SEQUENCE LISTING (9 sequences)

SEQ ID NO: 1 - protein, 590 aa, Plasmodium falciparum (isolate 3D7)
MNNYFLRKENFFILFCFVFVSIFFVSNVTIIKCNNVENKIDNVGKKIENVGKKIGDMENKNDNVENKNDNVGNKNDNVKNASSDLYKYKLYGDIDEYAYYFLDIDIGKPSQRISLILDTGSSSLSFPCNGCKDCGIHMEKPYNLNYSKTSSILYCNKSNCPYGLKCVGNKCEYLQSYCEGSQIYGFYFSDIVTLPSYNNKNKISFEKLMGCHMHEESLFLHQQATGVLGFSLTKPNGVPTFVDLLFKHTPSLKPIYSICVSEHGGELIIGGYEPDYFLSNQKEKQKMDKSDNNSSNKGNVSIKLKNNDKNDDEENNSKDVIVSNNVEDIVWQAITRKYYYYIKIYGLDLYGTNIMDKKELDMLVDSGSTFTHIPENIYNQINYYLDILCIHDMTNIYEINKRLKLTNESLNKPLVYFEDFKTALKNIIQNENLCIKIVDGVQCWKSLENLPNLYITLSNNYKMIWKPSSYLYKKESFWCKGLEKQVNNKPILGLTFFKNKQVIFDLQQNQIAFIESKCPSNLTSSRPRTFNEYREKENIFLKVSYINLYCLWLLLALTILLSLILYVRKMFYMDYFPLSDQNKSPIQEST

SEQ ID NO: 2 - protein, 536 aa, Plasmodium vivax (strain Salvador I)
MVGASLGPPGRGSLSRLIRLVICVLTLCALSVQGRSESTEGHSKDLLYKYKLYGDIDEYAYYFLDIDIGTPEQRISLILDTGSSSLSFPCAGCKNCGVHMENPFNLNNSKTSSILYCENEECPFKLNCVKGKCEYMQSYCEGSQISGFYFSDVVSVVSYNNERVTFRKLMGCHMHEESLFLYQQATGVLGMSLSKPQGIPTFVNLLFDNAPQLKQVFTICISENGGELIAGGYDPAYIVRRGGSKSVSGQGSGPVSESLSESGEDPQVALREAEKVVWENVTRKYYYYIKVRGLDMFGTNMMSSSKGLEMLVDSGSTFTHIPEDLYNKLNYFFDILCIQDMNNAYDVNKRLKMTNESFNNPLVQFDDFRKSLKSIIAKENMCVKIVDGVQCWKYLEGLPDLFVTLSNNYKMKWQPHSYLYKKESFWCKGIEKQVNNKPILGLTFFKNRQVIFDIQKNRIGFVDANCPSHPTHTRPRTYNEYKRKDNIFLKIPFFYLYSLFVVFALSVLLSLVFYVRRLYHMEYSPLPSEGKAPADA

SEQ ID NO: 3 - DNA, 1686 bp, Artificial Sequence
  Nucleotide sequence for recombinant P. vivax plasmepsin V (includes fusion tag comprising a FLAG tag, a SUMO domain and a TEV protease cleavage site)
gactacaaagacgatgacgacaaggggtccctgcaggactcagaagtcaatcaagaagctaagccagaggtcaagccagaagtcaagcctgagactcacatcaatttaaaggtgtccgatggatcttcagagatcttcttcaagatcaaaaagaccactcctttaagaaggctgatggaagcgttcgctaaaagacagggtaaggaaatggactccttaacgttcttgtacgacggtattgaaattcaagctgatcagacccctgaagatttggacatggaggataacgatattattgaggctcacagagaacagattggaggtgagaacttgtacttccaaggtacccgttccgagtctaccgagggccactccaaggacctgctgtacaagtacaagctgtacggcgacatcgacgagtacgcttactacttcctggacatcgacatcggcacccccgagcagcgcatctccctgatcctggataccggttcctccagcctgtccttcccttgcgctggttgcaagaactgcggtgtccacatggaaaaccccttcaacctgaacaactccaagacctcctccatcctgtactgcgagaacgaggaatgccctttcaagctgaactgcgtgaagggcaagtgcgagtacatgcagtcctactgcgagggttcccagatctccggtttctacttctccgacgtggtgtccgtcgtgtcctacaacaacgagcgtgtgaccttccgcaagctgatgggttgccacatgcacgaagagtccctgttcctctaccagcaagctaccggcgtgctgggcatgtccctgtccaagcctcagggtatccccaccttcgtgaacctgctgttcgacaacgctccccagctgaagcaagtgttcaccatctgcatctccgagaacggtggcgagctgatcgctggtggttacgaccccgcttacatcgtgcgtcgtggtggttccaagtccgtgtccggccagggttctggtcctgtgtccgagtctctgtctgagtccggcgaggacccccaagtggctctgagggaagctgagaaggtcgtgtgggagaacgtgacccgcaagtactactactacatcaaagtgcgcggcctggacatgttcggcaccaacatgatgtcctccagcaagggcctggaaatgctggtggattccggctccaccttcacccacatccccgaggacctgtacaacaagctcaactacttcttcgacatcctgtgcatccaagacatgaacaacgcctacgacgtgaacaagcgtctgaagatgaccaacgagtccttcaacaaccccctggtgcagttcgacgatttccgcaagtccctgaagtccatcatcgccaaggaaaatatgtgcgtgaagatcgtggacggcgtgcagtgctggaagtacctggaaggcctgcccgacctgttcgtgaccctgtctaacaactacaagatgaagtggcagccccactcctacctctacaagaaggaatctttctggtgcaagggcatcgagaagcaagtcaacaacaagcctatcctgggcctgaccttcttcaagaaccgtcaagtgatcttcgatatccagaagaaccgcatcggtttcgtggacgctaactgcccctcccaccctacccacactcgtcctagataataactcgag

SEQ ID NO: 4 - DNA, 1344 bp, Artificial Sequence
  Geneart synthetic gene with KPNI and XhoI restrictiion sites for insertion into pTriex2 vector
ggtacccgttccgagtctaccgagggccactccaaggacctgctgtacaagtacaagctgtacggcgacatcgacgagtacgcttactacttcctggacatcgacatcggcacccccgagcagcgcatctccctgatcctggataccggttcctccagcctgtccttcccttgcgctggttgcaagaactgcggtgtccacatggaaaaccccttcaacctgaacaactccaagacctcctccatcctgtactgcgagaacgaggaatgccctttcaagctgaactgcgtgaagggcaagtgcgagtacatgcagtcctactgcgagggttcccagatctccggtttctacttctccgacgtggtgtccgtcgtgtcctacaacaacgagcgtgtgaccttccgcaagctgatgggttgccacatgcacgaagagtccctgttcctctaccagcaagctaccggcgtgctgggcatgtccctgtccaagcctcagggtatccccaccttcgtgaacctgctgttcgacaacgctccccagctgaagcaagtgttcaccatctgcatctccgagaacggtggcgagctgatcgctggtggttacgaccccgcttacatcgtgcgtcgtggtggttccaagtccgtgtccggccagggttctggtcctgtgtccgagtctctgtctgagtccggcgaggacccccaagtggctctgagggaagctgagaaggtcgtgtgggagaacgtgacccgcaagtactactactacatcaaagtgcgcggcctggacatgttcggcaccaacatgatgtcctccagcaagggcctggaaatgctggtggattccggctccaccttcacccacatccccgaggacctgtacaacaagctcaactacttcttcgacatcctgtgcatccaagacatgaacaacgcctacgacgtgaacaagcgtctgaagatgaccaacgagtccttcaacaaccccctggtgcagttcgacgatttccgcaagtccctgaagtccatcatcgccaaggaaaatatgtgcgtgaagatcgtggacggcgtgcagtgctggaagtacctggaaggcctgcccgacctgttcgtgaccctgtctaacaactacaagatgaagtggcagccccactcctacctctacaagaaggaatctttctggtgcaagggcatcgagaagcaagtcaacaacaagcctatcctgggcctgaccttcttcaagaaccgtcaagtgatcttcgatatccagaagaaccgcatcggtttcgtggacgctaactgcccctcccaccctacccacactcgtcctagataataactcgag

SEQ ID NO: 5 - protein, 558 aa, Artificial Sequence
  recombinant P. vivax plasmepsin V including an N-terminal gp67 signal peptide, and a fusion tag comprised of a FLAG tag, SUMO domain and tobacco etch virus (TEV) protease cleavage site
DYKDDDDKGSLQDSEVNQEAKPEVKPEVKPETHINLKVSDGSSEIFFKIKKTTPLRRLMEAFAKRQGKEMDSLTFLYDGIEIQADQTPEDLDMEDNDIIEAHREQIGGENLYFQGTRSESTEGHSKDLLYKYKLYGDIDEYAYYFLDIDIGTPEQRISLILDTGSSSLSFPCAGCKNCGVHMENPFNLNNSKTSSILYCENEECPFKLNCVKGKCEYMQSYCEGSQISGFYFSDVVSVVSYNNERVTFRKLMGCHMHEESLFLYQQATGVLGMSLSKPQGIPTFVNLLFDNAPQLKQVFTICISENGGELIAGGYDPAYIVRRGGSKSVSGQGSGPVSESLSESGEDPQVALREAEKVVWENVTRKYYYYIKVRGLDMFGTNMMSSSKGLEMLVDSGSTFTHIPEDLYNKLNYFFDILCIQDMNNAYDVNKRLKMTNESFNNPLVQFDDFRKSLKSIIAKENMCVKIVDGVQCWKYLEGLPDLFVTLSNNYKMKWQPHSYLYKKESFWCKGIEKQVNNKPILGLTFFKNRQVIFDIQKNRIGFVDANCPSHPTHTRPR

SEQ ID NO: 6 - protein, 444 aa, Artificial Sequence
  recombinant P. vivax plasmepsin V after TEV cleavage (residues 35 to 476)
GTRSESTEGHSKDLLYKYKLYGDIDEYAYYFLDIDIGTPEQRISLILDTGSSSLSFPCAGCKNCGVHMENPFNLNNSKTSSILYCENEECPFKLNCVKGKCEYMQSYCEGSQISGFYFSDVVSVVSYNNERVTFRKLMGCHMHEESLFLYQQATGVLGMSLSKPQGIPTFVNLLFDNAPQLKQVFTICISENGGELIAGGYDPAYIVRRGGSKSVSGQGSGPVSESLSESGEDPQVALREAEKVVWENVTRKYYYYIKVRGLDMFGTNMMSSSKGLEMLVDSGSTFTHIPEDLYNKLNYFFDILCIQDMNNAYDVNKRLKMTNESFNNPLVQFDDFRKSLKSIIAKENMCVKIVDGVQCWKYLEGLPDLFVTLSNNYKMKWQPHSYLYKKESFWCKGIEKQVNNKPILGLTFFKNRQVIFDIQKNRIGFVDANCPSHPTHTRPR

SEQ ID NO: 7 - protein, 22 aa, Artificial Sequence
  peptide from knob-associated histidine-rich protein (KAHRP) containing PEXEL sequence RTLAQ
DABCYLRNKRTLAQKQEEDANS

SEQ ID NO: 8 - protein, 22 aa, Artificial Sequence
  peptide from knob-associated histidine-rich protein (KAHRP) containing PEXEL variant sequence KTLAQ
DABCYLRNKKTLAQKQEEDANS

SEQ ID NO: 9 - protein, 22 aa, Artificial Sequence
  peptide from knob-associated histidine-rich protein (KAHRP) containing variant PEXEL sequence RTIAQ
DABCYLRNKRTIAQKQEEDANS

(19) United States
(12) Patent Application Publication
(10) Pub. No.: US 2019/0065668 A1
(43) Pub. Date: Feb. 28, 2019

(54) STRUCTURE OF PLASMEPSIN V IN COMPLEX WITH AN INHIBITOR AND USES THEREOF

(71) Applicant: THE WALTER AND ELIZA HALL INSTITUTE OF MEDICAL RESEARCH, Melbourne, Victoria (AU)

(72) Inventors: Justin BODDEY, Melbourne, Victoria (AU); Alan COWMAN, Melbourne, Victoria (AU); Peter CZABOTAR, Melbourne, Victoria (AU); Tony HODDER, Melbourne, Victoria (AU); Brad SLEEBS, Melbourne, Victoria (AU)

(21) Appl. No.: 15/580,507

(22) PCT Filed: Jun. 8, 2016
(86) PCT No.: PCT/AU2016/050459

§ 371 Date: Dec. 7, 2017

(30) Foreign Application Priority Data
Jun. 9, 2015 (AU) 2015902134

(51) Int. Cl. G06F 19/16

(52) U.S. Cl. CPC G06F 19/16

(57) ABSTRACT

In one aspect, the present invention relates to the crystal structure of Plasmodium vivax plasmepsin V in complex with an inhibitor, and to methods of using the crystal structure and related structural information to identify, design and/or screen for inhibitors or redesign known inhibitors that interact with and/or modulate plasmepsin V activity. In another aspect, the present invention relates to a class of compounds based on the inhibitor useful in the treatment of malaria.

### TECHNICAL FIELD

The present invention relates generally to structural studies of plasmepsin V in complex with an inhibitor. In one aspect, the present invention relates to a crystal structure of plasmepsin V from Plasmodium vivax in complex with an inhibitor, and to methods of using the crystal structure and related structural information to identify, design and/or screen for inhibitors or redesign known inhibitors that interact with and/or modulate plasmepsin V activity. In another aspect, the present invention relates to a class of compounds based on the inhibitor useful in the treatment of malaria.

### BACKGROUND

Plasmodium falciparum and P. vivax are responsible for the most severe forms of malaria in humans. These parasites infect humans through the bite of an infected Anopheles mosquito. The parasites then migrate to the liver and develop into merozoites that are then released and invade erythrocytes in which they develop and amplify through successive rounds of infection.

Effector proteins exported to the host cell by the parasites (Marti M. et al., 2004; Hiller N. L. et al., 2004) are responsible for a remarkable process of cellular renovation that is induced in parasite-infected erythrocytes (reviewed in Boddey J. A. & Cowman A. F., 2013). Remodelling of the host cell provides the means for the parasite to gain nutrients and remain hidden from host protective responses in a relatively protected niche.

Plasmepsin V is an aspartyl protease expressed by protozoan parasites of Plasmodium spp. and known to play a pivotal role in the recognising and processing of effector proteins for export to the host cell (Boddey J. A., et al. 2010; Russo I., et al. 2010). The protease is a type I integral membrane-bound protease with the active domain located on the luminal side of the endoplasmic reticulum (“ER”) (Boddey J. A., et al. 2010; Russo I., et al. 2010; Sleebs B. E., et al. 2014a).

Plasmepsin V recognises and cleaves a pentameric sequence R×L×E/Q/D called the Plasmodium EXport ELement (“PEXEL”) (Marti M. et al., 2004) or Vacuolar Transport Signal (“VTS”) (Hiller N. L. et al., 2004) on the carboxy side of the leucine residue (Chang H. H. et al., 2008; Boddey J. A., et al. 2009). This motif is located 15 to 30 amino acids C-terminal to the hydrophobic ER-type signal sequence of over 400 proteins destined for export (Marti M. et al., 2004; Hiller N. L. et al., 2004; Sargeant T. J. et al. 2006). The processing step by plasmepsin V uncovers the export signal (xE/Q/D) that is acetylated and directs these proteins to the plasma membrane and the parasitophorous vacuole membrane (Boddey J. A., et al. 2010; Russo I., et al. 2010; Sleebs B. E., et al. 2014a; Boddey J. A., et al. 2009) that surrounds the parasite. The proteins are then recognised by Plasmodium Translocon of EXported proteins (“PTEX”), a protein machine that translocates them into the parasite-infected erythrocyte (Elsworth B., et al. 2014; Beck J. R. et al. 2014).

Cleavage of the PEXEL motif by plasmepsin V is essential for protein export in P. falciparum-infected erythrocytes as the gene encoding this enzyme cannot be disrupted (Boddey J. A., et al. 2010; Klemba M & Goldberg D. E. 2005). Indeed, expression of a dominant negative form of plasmepsin V in P. falciparum has been shown to block the export of proteins to the host erythrocyte suggesting it is required for this trafficking pathway (Russo I., et al. 2010; Sleebs B. E., et al. 2014a).

Also, PEXEL mimetic compounds containing statine, a molecule that possesses a hydroxyl functionality that mimics the transition state of amide bond proteolysis, have been shown to inhibit in vitro activity of P. falciparum and P. vivax plasmepsin V, block protein export and be lethal to P. falciparum growth (Sleebs B. E., et al. 2014a). This demonstrates that plasmepsin V plays a crucial role in protein export and that this process is essential for parasite survival, thus validating plasmepsin V as an important antimalarial target in asexual blood stages.

Currently, there is no structural information of plasmepsin V in an apo form or in complex with a substrate or inhibitor. Thus, there is no structural information detailing how substrates or inhibitors interact with the substrate-binding site of plasmepsin V nor structural information detailing how plasmepsin V functions in export after proteolysis.

Accordingly, there is a need to determine the structure of plasmepsin V in complex with an inhibitor in order to better understand the nature of plasmepsin V substrate or inhibitor interactions and to assist in the rational design or re-design of inhibitors to develop new antimalarials.

### SUMMARY OF INVENTION

The present invention is predicated in part by the determination of the crystal structure of plasmepsin V in complex with inhibitor WEHI-842, which allows visualisation, for the first time, of the structure of plasmepsin V as well as structural information detailing the substrate-binding site of plasmepsin V and its interactions with WEHI-842. The structure also identifies, for the first time, two features that are not present in canonical aspartyl proteases, namely a disulfide-bonded surface loop consisting of 17 amino acids, including four cysteine residues, and a helix-turn-helix motif. The atomic coordinates for the structure are presented in Appendix I.

As mentioned, the crystal structure reveals much needed structural information about the substrate-binding site of plasmepsin V through the binding of WEHI-842. The crystal structure reveals a canonical aspartyl protease fold including an enzyme domain comprised of a crescent-shaped and predominantly β-sheet core about the substrate-binding site. The enzyme domain includes N- and C-terminal subdomains that contact each other along a bottom of the substrate-binding site that contains the active site aspartates (Asp80 and Asp313). The amino and carboxyl ends of the plasmepsin V polypeptide are assembled into a characteristic six-stranded inter-domain β-sheet, which serves to anchor the N- and C-terminal subdomains together. The N-terminal subdomain further includes a distinctive β-hairpin loop structure, known as a “flap”, which lies perpendicular over the substrate-binding site and interacts with the bound WEHI-842.

The present invention is also predicated by development of inhibitor WEHI-842. WEHI-842 was developed from its precursor WEHI-916, which mimics the transition-state of amide bond proteolysis for PEXEL substrates using statine (Sleebs B. E., et al. 2014a). Whilst WEHI-916 was a good inhibitor of plasmepsin V protease activity in vitro, it was not particularly potent in blocking P. falciparum growth (EC50 5 μM) and the present inventors hypothesised that this was due to the highly polarized guanidium group on the P3 Arg of the transition state mimetic that impairs permeability across membranes.

In contrast, WEHI-842 has a non-proteinogenic amino acid canavanine, which replaces the P3 Arg in WEHI-916 and also an N-terminal carbamate that replaces the sulfonamide seen in WEHI-916. WEHI-842 has been observed to be a more potent inhibitor of plasmepsin V and of P. falciparum growth than WEHI-916. From previous studies, it is known that the exchange of the sulfonamide with a carbamate has no effect on binding affinity to plasmepsin V or parasite activity (Gazdik M. et al. 2015), so the improvement in activities seen with WEH-842 is attributed to replacing the P3 Arg with canavanine.

With the foregoing in view, one aspect of the present invention provides a plasmepsin V/WEHI-842 crystalline complex having the atomic coordinates as set forth in Appendix I. Generally, the crystalline complex comprising plasmepsin V and WEHI-842 or derivatives or components thereof are in essentially a pure native form.

Another aspect of the present invention is directed to a dataset of atomic coordinates defining the interaction between plasmepsin V and WEHI-842. In one embodiment, the dataset of atomic coordinates defines the interaction between the substrate-binding site of plasmepsin V and WEHI-842. In another embodiment, the dataset of atomic coordinates defines the interaction between the flap of plasmepsin V and WEHI-842.

Yet another aspect of the present invention is directed to conformational mimetics of the substrate-binding site surface of WEHI-842. The mimetics may interfere directly or interact directly with the substrate-binding site of plasmepsin V and/or with the flap of plasmepsin V or may interact elsewhere causing conformational changes to the substrate-binding site and/or the flap.

In one embodiment, a substrate-binding site and/or flap inhibitor is proposed to, for example, block or at least reduce cleavage of the PEXEL motif of effector proteins by plasmepsin V to inhibit or at least reduce the activity of P. falciparum and P. vivax plasmepsin V, block or at least reduce protein export and optionally be lethal to P. falciparum and/or P. vivax growth.

In another embodiment, a substrate-binding site and/or flap inhibitor is proposed, for example, in the treatment of malaria.

Accordingly, the present invention in one form resides in a plasmepsin V/WEHI-842 complex in crystalline form or a derivative, homologue, component and/or soluble form thereof.

In one embodiment, the complex comprises at least part of a plasmepsin V polypeptide chain in complex with WEHI-842.

In a preferred embodiment, the complex includes an enzyme domain from the plasmepsin V polypeptide chain in complex with WEHI-842.

In another preferred embodiment, the complex includes at least part of an N-terminal subdomain of the enzyme domain from the plasmepsin V polypeptide chain and at least part of a C-terminal subdomain of the enzyme domain from the plasmepsin V polypeptide chain, wherein the at least part of the N-terminal subdomain and the at least part of the C-terminal subdomain together define the substrate-binding site of the plasmepsin V polypeptide chain in complex with WEHI-842.

In a more preferred embodiment, the N-terminal subdomain includes at least part of a disulfide-bonded surface loop.

In another more preferred embodiment, the N-terminal subdomain includes at least part of the β-hairpin structure (known as the “flap”).

In yet another more preferred embodiment, the C-terminal subdomain includes at least part of the helix-turn-helix motif.

In a further preferred embodiment, the complex comprises at least part of the substrate-binding site of plasmepsin V in complex with at least a portion of WEHI-842, preferably the complex also comprises at least part of the flap.

In a yet further preferred embodiment, the complex comprises at least part of the substrate-binding site of plasmepsin V including the S1, S2 and S3 binding pockets, wherein: the S1 binding pocket includes amino acids Ile78, Tyr139, Phe180 and Val188; the S2 binding pocket includes amino acid Gly315; and the S3 binding pocket includes amino acids Glu141 and Gln183.

In a most preferred embodiment, the complex comprises the components of the structure defined by the atomic coordinates shown in Appendix I or a subset a thereof.

The present invention in another form provides a method of identifying, designing and/or screening for a compound that can potentially interact with plasmepsin V, preferably the substrate-binding site and/or the flap of plasmepsin V, including performing structure-based identification, design and/or screening of a compound based on the compound's interaction with a plasmepsin V structure defined by the atomic coordinates of Appendix I or a subset thereof.

In another form, the present invention provides a method of identifying, designing and/or screening for a compound that can potentially mimic WEHI-842 interacting with plasmepsin V, including performing structure-based identification, design and/or screening of a compound based on (i) the compound's interaction with a plasmepsin V structure and/or (ii) the compound's similarity with a WEHI-842 structure in complex with a plasmepsin V structure defined by the atomic coordinates of Appendix I or a subset thereof.

In one embodiment, the method includes identifying, designing and/or screening for a compound which interacts with the three-dimensional structure of the substrate-binding site and/or the flap of plasmepsin V, the structure being defined by the atomic coordinates shown in Appendix I, wherein interaction of the compound with the structure is favoured energetically.

In another embodiment, the method includes identifying, designing and/or screening for a compound based upon the three-dimensional structure of WEHI-842 in complex with components of the substrate-binding site and/or the flap of plasmepsin V, the structure being defined by the atomic coordinates shown in Appendix I or a subset thereof, wherein interaction of the compound with the structure is favoured energetically.

The present invention in another form provides a method of identifying an inhibitor compound comprising an entity selected from the group consisting of an antibody, an antigen-binding fragment, a peptide, a non-peptide molecule and a chemical compound, wherein said inhibitor compound is capable of blocking biological activity resulting from an interaction with plasmepsin V, wherein said process includes:
introducing into a suitable computer program parameters defining an interacting surface based on the conformation of plasmepsin V in complex with WEHI-842 corresponding to the atomic coordinates of Appendix I or a subset thereof, wherein said program displays a three-dimensional model of the interacting surface;
creating a three-dimensional structure of a test compound in said computer program;
displaying a superimposing model of said test compound on the three-dimensional model of the interacting surface;
assessing whether said superimposing model of said test compound fits spatially and optionally energetically into a binding site;
optionally, synthesising said test compound;
optionally, incorporating said test compound in a biological activity assay; and
optionally, determining whether said test compound inhibits the biological activity of plasmepsin V.

In one embodiment, the method includes identifying an inhibitor compound capable of interacting with at least part of the substrate-binding site and/or the flap of plasmepsin V as defined by the atomic coordinates shown in Appendix I, preferably the entire substrate-binding site and the flap.

In a further embodiment, the atomic coordinates as shown in Appendix I or a subset thereof define one or more regions of WEHI-842 in complex with plasmepsin V.

In a preferred embodiment, the atomic coordinates as shown in Appendix I or a subset thereof define WEHI-842 in complex with at least part of the substrate-binding site from the plasmepsin V polypeptide chain and at least part of the flap from the N-terminal subdomain of the plasmepsin V polypeptide chain.

In another preferred embodiment, the atomic coordinates as shown in Appendix I or a subset thereof define portions of the molecular surface of the substrate binding site of plasmepsin V and the flap from the N-terminal subdomain from plasmepsin V, which interact with at least a portion of the molecular surface of WEHI-842.

In another embodiment, the atomic coordinates or a subset thereof define one or more amino acids selected from 44 to 240 and 273 to 470 of plasmepsin V of P. vivax in complex with WEHI-842.

In another preferred embodiment, the one or more amino acids selected from 44 to 240 and 273 to 470 of plasmepsin V include one or more amino acids selected from the group consisting of Tyr59, Ala60, Ile78, Asp80, Gly82, Tyr139, Cys140, Glu141, Phe180, Gln183, Val188, Asp313, Gly315 and Thr317.

In another preferred embodiment, the atomic coordinates as shown in Appendix I or a subset thereof define at least part of the substrate-binding site of plasmepsin V including the S1, S2 and S3 binding pockets, wherein: the S1 binding pocket includes amino acids Ile78, Tyr139, Phe180 and Val188; the S2 binding pocket includes residue Gly315; and the S3 binding pocket includes amino acids Glu141 and Gln183.

In another form, the present invention includes use of the atomic coordinates or a subset thereof as shown in Appendix I at least representing:
(i) WEHI-842; and/or
(ii) one or more regions of WEHI-842 in complex with one or more regions of plasmepsin V,
in identifying, designing and/or screening for a compound that can potentially mimic WEHI-842 interacting with plasmepsin V, including performing structure-based identification, design and/or screening of a compound based on (a) the compound's interaction with a plasmepsin V structure and/or (b) the compound's similarity with WEHI-842 in complex with plasmepsin V as defined by the atomic coordinates or a subset thereof.

In another form, the present invention includes use of the atomic coordinates or a subset thereof as shown in Appendix I at least representing:
(i) the enzyme domain of plasmepsin V;
(ii) the N-terminal subdomain of plasmepsin V;
(iii) the C-terminal subdomain of plasmepsin V;
(iv) the substrate-binding site of plasmepsin V;
(v) the flap from the N-terminal subdomain from plasmepsin V;
(vi) one or more regions of the flap in complex with WEHI-842; and/or
(vii) one or more regions of the substrate-binding site in complex with WEHI-842, in identifying, designing and/or screening for a compound that can potentially interact with plasmepsin V, including performing structure-based identification, design and/or screening of a compound based on the compound's interactions with a plasmepsin V structure as defined by the atomic coordinates or a subset thereof.

In another form, the present invention includes a set of atomic coordinates as shown in Appendix I, or a subset thereof, at least representing:
(i) the enzyme domain of plasmepsin V;
(ii) the N-terminal subdomain of plasmepsin V;
(iii) the C-terminal subdomain of plasmepsin V;
(iv) the substrate-binding site of plasmepsin V;
(v) the flap from the N-terminal subdomain from plasmepsin V;
(vi) one or more regions of the flap in complex with WEHI-842;
(vii) one or more regions of the substrate-binding site in complex with WEHI-842; and/or
(viii) one or more regions of WEHI-842 in complex with plasmepsin V.

In another form, the present invention includes an inhibitor of a site comprising one or more amino acids selected from 44 to 240 and 273 to 470 of plasmepsin V, including one or more amino acids selected from the group consisting of Tyr59, Ala60, Ile78, Asp80, Gly82, Tyr139, Cys140, Glu141, Phe180, Gln183, Val188, Asp313, Gly315 and Thr317. In one embodiment, the site comprises one or more amino acids forming at least part of the substrate-binding site of plasmepsin V including the S1, S2 and S3 binding pockets, wherein: the S1 binding pocket includes amino acids Ile78, Tyr139, Phe180 and Val188; the S2 binding pocket includes amino acid Gly315; and the S3 binding pocket includes amino acids Glu141 and Gln183. In one embodiment, the inhibitor of the site may be an isolated, synthetic, purified, recombinant and/or non-naturally occurring inhibitor.

The present invention has enabled the identification of molecular surface interactions between WEHI-842 and the substrate-binding site and/or the flap of plasmepsin V. In particular, the present invention has enabled the determination of key amino acids involved in the binding of WEHI-842 to the substrate-binding site and/or the flap. It will be evident to a person skilled in the art that these findings can be transposed on to related aspartyl proteases including homologous plasmepsin V from Plasmodium spp., including P. falciparum.

The present invention is therefore also useful in the identification and/or design of candidate compounds that bind to the substrate-binding site and/or interact with the flap of related aspartyl proteases, including homologous plasmepsin V from Plasmodium spp., including P. falciparum.

In one embodiment, candidate compounds for interacting with plasmepsin V or related aspartyl proteases may be chemically modified as a result of structure-based evaluation using the atomic coordinates as defined in Appendix I or a subset thereof.

Candidate compounds and compounds identified or designed using a method or process of the present invention may be any suitable compound, including naturally occurring compounds, de novo designed compounds, library generated compounds (chemically or recombinantly generated), mimetics etc., and may include organic compounds, new chemical entities, antibodies, binding proteins other than antibody-based molecules (non-immunoglobulin proteins) including, for example, protein scaffolds, designed ankyrin repeat proteins (DARPins, Stumpp et al., 2007) and protein A domains (reviewed in Binz et al, 2005), avimers (Silverman et al., 2005), and other new biological entities such as nucleic acid aptamers (reviewed in Ulrich, 2006).

The present invention is also useful for improving the properties of ligands for the substrate-binding site of plasmepsin V and/or related aspartyl proteases. For example, existing ligands may be screened against the 3D structure of the substrate-binding site and/or the flap of plasmepsin V or a region thereof as defined by the atomic coordinates of Appendix I or a subset thereof, and an assessment made of the potential to energetically interact with the substrate-binding site and/or the flap of plasmepsin V.

Similarly, existing substrate-binding ligands can be screened against the 3D structure of the substrate-binding surface and/or the flap-interacting surface of WEHI-842 bound to plasmepsin V as defined by the atomic coordinates of Appendix I or a subset thereof, and an assessment made of the potential to energetically interact with the substrate-binding site and/or the flap of plasmepsin V.

Thus, the present invention also provides a method of re-designing a compound which is known to bind to plasmepsin V comprising performing structure-based evaluation of the compound based on the compound's interactions with a plasmepsin V structure defined by the atomic coordinates of Appendix I or a subset thereof and re-designing or chemically modifying the compound as a result of the evaluation.

In another form, the present invention provides a method of re-designing a compound which is known to bind to plasmepsin V comprising performing structure-based evaluation of the compound's similarity with a structure of WEHI-842 in complex with plasmepsin V as defined by the atomic coordinates of Appendix I or a subset thereof and re-designing or chemically modifying the compound as a result of the evaluation.

In one embodiment, the compound which is known to bind to plasmepsin V is re-designed or chemically modified to (i) improve affinity for binding to plasmepsin V, and/or (ii) optionally, lower affinity for binding to other aspartyl proteases, such as, e.g., plasmepsin I-IV.

In another embodiment, the method may further include synthesising the compound once re-designed or chemically modified, and optionally incorporating said compound once re-designed or chemically modified in a biological activity assay, preferably to determine whether said compound inhibits the biological activity of plasmepsin V.

The present invention also provides a computer system for identifying one or more compounds that can potentially interact with plasmepsin V, the system containing data representing the structure of: (i) the substrate-binding site of plasmepsin V, the structure being defined by a subset of the atomic coordinates shown in Appendix I; (ii) the flap of plasmepsin V, the structure being defined by a subset of the atomic coordinates shown in Appendix I; (iii) the substrate-binding site surface on WEHI-842, the structure being defined by a subset of the atomic coordinates shown in Appendix I; (iv) the flap-interacting surface on WEHI-842, the structure being defined by a subset of the atomic coordinates shown in Appendix I; and/or (v) a combination thereof, the structure being defined by the atomic coordinates shown in Appendix I or a subset thereof.

In another aspect, the present invention provides a computer-readable medium having recorded data thereon representing a model and/or the atomic coordinates as shown in Appendix I, or a subset of atomic coordinates thereof, the model and/or the atomic coordinates at least representing:
(i) the enzyme domain of plasmepsin V;
(ii) the N-terminal subdomain of plasmepsin V;
(iii) the C-terminal subdomain of plasmepsin V;
(iv) the substrate-binding site of plasmepsin V;
(v) the flap from the N-terminal subdomain from plasmepsin V;
(vi) one or more regions of the flap in complex with WEHI-842;
(vii) one or more regions of the substrate-binding site in complex with WEHI-842;
(viii) one or more regions of WEHI-842 in complex with plasmepsin V;
(ix) one or more regions of WEHI-842 in complex with the substrate-binding site; and/or
(x) one or more regions of WEHI-842 in complex with the flap.

Also provided are a set of atomic coordinates as shown in Appendix I, or a subset thereof, at least representing:
(i) the enzyme domain of plasmepsin V;
(ii) the N-terminal subdomain of plasmepsin V;
(iii) the C-terminal subdomain of plasmepsin V;
(iv) the substrate-binding site of plasmepsin V;
(v) the flap from the N-terminal subdomain from plasmepsin V;
(vi) one or more regions of the flap in complex with WEHI-842;
(vii) one or more regions of the substrate-binding site in complex with WEHI-842;
(viii) one or more regions of WEHI-842 in complex with plasmepsin V;
(ix) one or more regions of WEHI-842 in complex with the substrate-binding site; and/or
(x) one or more regions of WEHI-842 in complex with the flap.

The three-dimensional structure of plasmepsin V and/or substrate-binding site of plasmepsin V and/or the flap of plasmepsin V and/or WEHI-842 and/or the one or more regions of WEHI-842 in complex with plasmepsin V and/or the one or more regions of WEHI-842 in complex with the substrate-binding site of plasmepsin V and/or the one or more regions of WEHI-842 in complex with the flap of plasmepsin V may be used to develop models useful for drug design and/or in silico screening of candidate compounds that interact with and/or modulate plasmepsin V. Other physicochemical characteristics may also be used in developing the model, e.g. bonding, electrostatics, etc.

Generally, the term “in silico” refers to the creation in a computer memory, i.e., on a silicon or other like chip. Stated otherwise “in silico” means “virtual”. When used herein the term “in silico” is intended to refer to screening methods based on the use of computer models rather than in vitro or in vivo experiments.

Accordingly, the present invention also provides a computer-assisted method of identifying a compound that potentially interacts with plasmepsin V, which method comprises fitting the structure of: (i) the substrate-binding site of plasmepsin V, the structure being defined by a subset of the atomic coordinates shown in Appendix I; and/or (ii) portions of plasmepsin V, preferably including the flap, the structure being defined by a subset of the atomic coordinates shown in Appendix I, to the structure of a candidate compound.

Also provided by the present invention is a computer-assisted method of identifying a molecule able to interact with plasmepsin V using a programmed computer comprising a processor, which method comprises the steps of: (a) generating, using computer methods, a set of atomic coordinates of a structure that possesses energetically favourable interactions with the atomic coordinates of: (i) the substrate-binding site of plasmepsin V, the structure being defined by a subset of the atomic coordinates shown in Appendix I; and/or (ii) at least portions of plasmepsin V, preferably including the flap, the structure being defined by a subset of the atomic coordinates shown in Appendix I, which coordinates are entered into the computer thereby generating a criteria data set; (b) comparing, using the processor, the criteria data set to a computer database of chemical structures; (c) selecting from the database, using computer methods, chemical structures which are complementary or similar to a region of the criteria data set; and (d) optionally, outputting, to an output device, the selected chemical structures which are complementary to or similar to a region of the criteria data set.

The present invention further provides a computer-assisted method of identifying potential mimetics of WEHI-842 using a programmed computer comprising a processor, the method comprising the steps of: (a) generating a criteria data set from a set of atomic coordinates of: (i) the substrate-binding site of plasmepsin V, the structure being defined by a subset of the atomic coordinates shown in Appendix I; (ii) at least a portion of plasmepsin V, preferably including the flap, the structure being defined by a subset of the atomic coordinates shown in Appendix I; and/or WEHI-842, the structure being defined by a subset of the atomic coordinates shown in Appendix I, which coordinates are entered into the computer; (b)(i) comparing, using the processor, the criteria data set to a computer database of chemical structures stored in a computer data storage system and selecting from the database, using computer methods, chemical structures having a region that is structurally similar to the criteria data set; or (ii) constructing, using computer methods, a model of a chemical structure having a region that is structurally similar to the criteria data set; and (c) optionally, outputting to an output device: (i) the selected chemical structures from step (b)(i) having a region similar to the criteria data set; or (ii) the constructed model from step (b)(ii).

The present invention further provides a method of evaluating the ability of a compound to interact with plasmepsin V, the method comprising the steps of: (a) employing computational means to perform: (i) a fitting operation between the compound and the binding surface of a computer model of the substrate-binding site for WEHI-842 on plasmepsin V; and/or (ii) a superimposing operation between the compound and WEHI-842, the substrate-binding site for WEHI-842 on plasmepsin V or a portion thereof, using atomic coordinates wherein the root mean square deviation between the atomic coordinates and a subset of atomic coordinates of Appendix I or a subset of atomic coordinates of one or more thereof at least representing the substrate-binding site of plasmepsin V or a portion thereof, the flap or a portion thereof, plasmepsin V or WEHI-842, is not more than 1.5 Å; and (b) analysing the results of the fitting operation and/or superimposing operation to quantify the association between the compound and a binding surface model.

The present invention also provides a method of using molecular replacement to obtain structural information about a molecule or a molecular complex of an unknown structure, comprising the steps of: (i) generating an X-ray diffraction pattern of the crystallized molecule or molecular complex; and (ii) applying the atomic coordinates of Appendix I, or a subset of atomic coordinates thereof at least representing plasmepsin V, the substrate-binding site of plasmepsin V, the flap of plasmepsin V, WEHI-842, mimetics thereof, derivatives thereof or portions thereof, to the X-ray diffraction pattern to generate a three-dimensional electron density map of at least a region of the molecule or molecular complex whose structure is unknown.

The present invention also encompasses compounds that bind to plasmepsin V designed, re-designed and/or modified using the methods or processes of the present invention. Preferably, such compounds have an affinity (KD) for plasmepsin V of less than 10⁻⁷ M. Preferably, the compounds bind to the substrate-binding site of plasmepsin V. More preferably, the compounds bind to the substrate-binding site and the flap of plasmepsin V.

In another aspect, the present invention relates to a compound of Formula I or a pharmaceutically acceptable salt thereof:

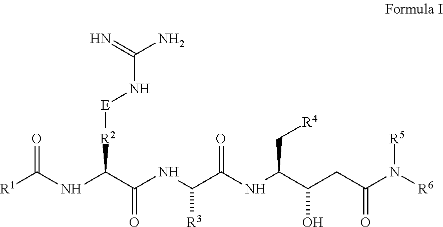

wherein:
E is O or S;
R¹ is —Z—C(R⁹)—R¹⁰, —Z—C(R⁹)—C(O)—R¹⁰; —Z—C(R⁹)—C(O)—N(R¹¹)—R¹⁰;
Z is a bond, O, S or N(R¹²);
R² is —C(R⁷)₂—C(R⁷)₂—, —CR⁷═CR⁷— or

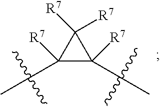

R³ is selected from the group consisting of: hydrogen, —C₁₋₇alkyl, —C₁₋₇haloalkyl, —C₂₋₇alkenyl, —C₂₋₇alkynyl, —C₀₋₇alkylOH, —C₀₋₇alkylCO₂H, —C₀₋₇alkylCONH₂, —C₀₋₇alkylNH₂, —C₀₋₇alkylSH, —C₀₋₄alkylSC₁₋₄alkyl, —C₀₋₆alkylNHC(═NH)NH₂, —C₀₋₆alkylaryl, —C₀₋₆alkylcycloalkyl, —C₀₋₆alkylheterocyclyl, and —C₀₋₆alkylheteroaryl; wherein the alkyl, alkenyl or alkynyl groups are optionally substituted by one or more of: halo, hydroxy, carboxy, —CONH₂, —CON(alkyl)₂, —CONHalkyl, —NH₂, —N(alkyl)₂ and —NHalkyl; and wherein the aryl, cycloalkyl, heterocyclyl or heteroaryl groups are optionally substituted by one or more of halo, hydroxy, carboxy, alkyl, alkenyl, alkynyl, haloalkyl, hydroxyalkyl, alkoxy, haloalkoxy, —CO-alkyl, -alkyl-CO-alkyl, —CO—O-alkyl, -alkyl-CO—O-alkyl, —CONH₂, —CON(alkyl)₂, —CONHalkyl, —NH₂, —N(alkyl)₂, —NHalkyl, -alkyl-CONH₂, -alkyl-CON(alkyl)₂, -alkyl-CONHalkyl, -alkyl-NH₂, -alkyl-N(alkyl)₂ and -alkyl-NHalkyl;
R⁴ is branched alkyl optionally substituted by halo or hydroxy, or

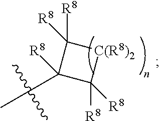

n is an integer from 0-7;
R⁵ is hydrogen, alkyl or haloalkyl;
R⁶ is —C(R¹⁴)—R¹⁵, —C(R¹⁴)—C(O)—R¹⁵; —C(R¹⁴)—C(O)—N(R¹⁶)—R¹⁵;
each R⁷ is independently hydrogen, halogen or hydroxy;
each R⁸ is independently hydrogen, halogen or hydroxy;
R⁹ is selected from the group consisting of: hydrogen, —C₁₋₇alkyl, —C₁₋₇haloalkyl, —C₂₋₇alkenyl, —C₂₋₇alkynyl, —C₀₋₇alkylOH, —C₀₋₇alkylCO₂H, —C₀₋₇alkylCONH₂, —C₀₋₇alkylNH₂, —C₀₋₇alkylSH, —C₀₋₄alkylSC₁₋₄alkyl, —C₀₋₆alkylNHC(═NH)NH₂, —C₀₋₆alkylaryl, —C₀₋₆alkylcycloalkyl, —C₀₋₆alkylheterocyclyl, and —C₀₋₆alkylheteroaryl; wherein the alkyl, alkenyl or alkynyl groups are optionally substituted by one or more of: halo, hydroxy, carboxy, —CONH₂, —CON(alkyl)₂, —CONHalkyl, —NH₂, —N(alkyl)₂ and —NHalkyl; and wherein the aryl, cycloalkyl, heterocyclyl or heteroaryl groups are optionally substituted by one or more of halo, hydroxy, carboxy, alkyl, alkenyl, alkynyl, haloalkyl, hydroxyalkyl, alkoxy, haloalkoxy, —CO-alkyl, -alkyl-CO-alkyl, —CO—O-alkyl, -alkyl-CO—O-alkyl, —CONH₂, —CON(alkyl)₂, —CONHalkyl, —NH₂, —N(alkyl)₂, —NHalkyl, -alkyl-CONH₂, -alkyl-CON(alkyl)₂, -alkyl-CONHalkyl, -alkyl-NH₂, -alkyl-N(alkyl)₂ and -alkyl-NHalkyl;
R¹⁰ is selected from the group consisting of: hydrogen, —R¹³, -alkyl-R¹³, -alkenyl-R¹³ and alkynyl-R¹³; wherein the alkyl, alkenyl or alkynyl groups are optionally substituted by one or more of: halo, hydroxy, carboxy, —CONH₂, —CON(alkyl)₂, —CONHalkyl, —NH₂, —N(alkyl)₂ and —NHalkyl;
R¹¹ is hydrogen, alkyl or haloalkyl;
R¹² is hydrogen, alkyl or haloalkyl;
R¹³ is hydrogen, aryl, cycloalkyl, heterocyclyl or heteroaryl; wherein the aryl, cycloalkyl, heterocyclyl or heteroaryl groups are optionally substituted by one or more R¹;
R¹⁴ is selected from the group consisting of: hydrogen, —C₁₋₇alkyl, —C₁₋₇haloalkyl, —C₂₋₇alkenyl, —C₂₋₇alkynyl, —C₀₋₇alkylOH, —C₀₋₇alkylCO₂H, —C₀₋₇alkylCONH₂, —C₀₋₇alkylNH₂, —C₀₋₇alkylSH, —C₀₋₄alkylSC₁₋₄alkyl, —C₀₋₆alkylNHC(═NH)NH₂, —C₀₋₆alkylaryl, —C₀₋₆alkylcycloalkyl, —C₀₋₆alkylheterocyclyl, and —C₀₋₆alkylheteroaryl; wherein the alkyl, alkenyl or alkynyl groups are optionally substituted by one or more of: halo, hydroxy, carboxy, —CONH₂, —CON(alkyl)₂, —CONHalkyl, —NH₂, —N(alkyl)₂ and —NHalkyl; and wherein the aryl, cycloalkyl, heterocyclyl or heteroaryl groups are optionally substituted by one or more of halo, hydroxy, carboxy, alkyl, alkenyl, alkynyl, haloalkyl, hydroxyalkyl, alkoxy, haloalkoxy, —CO-alkyl, -alkyl-CO-alkyl, —CO—O-alkyl, -alkyl-CO—O-alkyl, —CONH₂, —CON(alkyl)₂, —CONHalkyl, —NH₂, —N(alkyl)₂, —NHalkyl, -alkyl-CONH₂, -alkyl-CON(alkyl)₂, -alkyl-CONHalkyl, -alkyl-NH₂, -alkyl-N(alkyl)₂ and -alkyl-NHalkyl;
R¹⁵ is selected from the group consisting of: hydrogen, —R¹⁷, -alkyl-R¹⁷, -alkenyl-R¹⁷ and alkynyl-R¹⁷; wherein the alkyl, alkenyl or alkynyl groups are optionally substituted by one or more of: halo, hydroxy, carboxy, —CONH₂, —CON(alkyl)₂, —CONHalkyl, —NH₂, —N(alkyl)₂ and —NHalkyl;
R¹⁶ is hydrogen, alkyl or haloalkyl;
R¹⁷ is hydrogen, aryl, cycloalkyl, heterocyclyl or heteroaryl; wherein the aryl, cycloalkyl, heterocyclyl or heteroaryl groups are optionally substituted by one or more R¹⁹;
R¹⁸ is selected from the group consisting of: halo, hydroxy, carboxy, alkyl, alkenyl, alkynyl, haloalkyl, hydroxyalkyl, alkoxy, haloalkoxy, —CO-alkyl, -alkyl-CO-alkyl, —CO—O-alkyl, -alkyl-CO—O-alkyl, —CONH₂, —CON(alkyl)₂, —CONHalkyl, —NH₂, —N(alkyl)₂, —NHalkyl, -alkyl-CONH₂, -alkyl-CON(alkyl)₂, -alkyl-CONHalkyl, -alkyl-NH₂, -alkyl-N(alkyl)₂ and -alkyl-NHalkyl; and
R¹⁹ is selected from the group consisting of: halo, hydroxy, carboxy, alkyl, alkenyl, alkynyl, haloalkyl, hydroxyalkyl, alkoxy, haloalkoxy, —CO-alkyl, -alkyl-CO-alkyl, —CO—O-alkyl, -alkyl-CO—O-alkyl, —CONH₂, —CON(alkyl)₂, —CONHalkyl, —NH₂, —N(alkyl)₂, —NHalkyl, -alkyl-CONH₂, -alkyl-CON(alkyl)₂, -alkyl-CONHalkyl, -alkyl-NH₂, -alkyl-N(alkyl)₂ and -alkyl-NHalkyl.

In some embodiments of the compounds of formula (I), one or more of the following applies:
E is O;
R¹ is —Z—C(R⁹)—R¹⁰;
Z is O;
R² is —C(R⁷)₂—C(R⁷)₂—; especially —CH₂—CH₂—;
R³ is —C₁₋₇alkyl or —C₁₋₇haloalkyl; especially —CH—(C₁₋₃alkyl)₂ or —CH—(C₁₋₃haloalkyl)₂; most especially —CH(CH₃)₂;
R⁴ is branched alkyl optionally substituted by halo or hydroxy; especially —CR⁸—[(C(R⁸)₂)ₘ—C(R⁸)₃]₂, wherein each m is independently an integer from 0-6 (especially 0, 1, 2, 3 or 4; most especially 0); more especially CH—(CH₃)₂;
n is 0, 1, 2, 3 or 4; especially 0, 1 or 2; most especially 0;
R⁵ is hydrogen or alkyl; especially hydrogen;
R⁶ is —C(R¹⁴)—R¹⁵;
R⁷ is hydrogen or halogen; especially hydrogen, fluorine or chlorine; more especially hydrogen or fluorine; most especially hydrogen;
R⁸ is hydrogen or halogen; especially hydrogen, fluorine or chlorine; more especially hydrogen or fluorine; most especially hydrogen;
R⁹ is selected from the group consisting of: hydrogen, —C₁₋₇alkyl, —C₁₋₇haloalkyl, —C₂₋₇alkenyl, —C₂₋₇alkynyl, —C₀₋₇alkylOH, —C₀₋₆alkylaryl, —C₀₋₆alkylcycloalkyl, —C₀₋₆alkylheterocyclyl, and —C₀₋₆alkylheteroaryl; especially from the group consisting of: hydrogen, —C₁₋₇alkyl and —C₁₋₇haloalkyl; more especially hydrogen; wherein the alkyl, alkenyl or alkynyl groups are optionally substituted by one or more of: halo, hydroxy, carboxy, —CONH₂, —CON(alkyl)₂, —CONHalkyl, —NH₂, —N(alkyl)₂ and —NHalkyl; and wherein the aryl, cycloalkyl, heterocyclyl or heteroaryl groups are optionally substituted by one or more of halo, hydroxy, carboxy, alkyl, alkenyl, alkynyl, haloalkyl, hydroxyalkyl, alkoxy, haloalkoxy, —CO-alkyl, -alkyl-CO-alkyl, —CO—O-alkyl, -alkyl-CO—O-alkyl, —CONH₂, —CON(alkyl)₂, —CONHalkyl, —NH₂, —N(alkyl)₂, —NHalkyl, -alkyl-CONH₂, -alkyl-CON(alkyl)₂, -alkyl-CONHalkyl, -alkyl-NH₂, -alkyl-N(alkyl)₂ and -alkyl-NHalkyl;
R¹⁰ is selected from the group consisting of: —R¹³, -alkyl-R¹³, -alkenyl-R¹³ and alkynyl-R¹³; especially R¹³; wherein the alkyl, alkenyl and alkynyl groups are optionally substituted by one or more of: halo, hydroxy, carboxy, —CONH₂, —CON(alkyl)₂ (especially —CON(C₁₋₆alkyl)₂), —CONHalkyl (especially —CONHC₁₋₆alkyl), —NH₂, —N(alkyl)₂ (especially —N(C₁₋₆alkyl)₂) and —NHalkyl (especially —NHC₁₋₆alkyl);
R¹¹ is hydrogen;
R¹² is hydrogen;
R¹³ is aryl (especially C₆₋₁₀ aryl), cycloalkyl (especially C₃₋₁₀cycloalkyl), heterocyclyl (especially C₃₋₁₀heterocyclyl) or heteroaryl (especially C₆₋₁₀heteroaryl), more especially aryl (especially C₆₋₁₀aryl); most especially phenyl; wherein the aryl, cycloalkyl, heterocyclyl and heteroaryl groups are optionally substituted by one or more R¹⁸;
R¹⁴ is selected from the group consisting of: hydrogen, —C₁₋₇alkyl, —C₁₋₇haloalkyl, —C₂₋₇alkenyl, —C₂₋₇alkynyl, —C₀₋₇alkylOH, —C₀₋₆alkylaryl, —C₀₋₆alkylcycloalkyl, —C₀₋₆alkylheterocyclyl, and —C₀₋₆alkylheteroaryl; especially from the group consisting of: hydrogen, —C₁₋₇alkyl and —C₁₋₇haloalkyl; more especially hydrogen; wherein the alkyl, alkenyl or alkynyl groups are optionally substituted by one or more of: halo, hydroxy, carboxy, —CONH₂, —CON(alkyl)₂, —CONHalkyl, —NH₂, —N(alkyl)₂ and —NHalkyl; and wherein the aryl, cycloalkyl, heterocyclyl or heteroaryl groups are optionally substituted by one or more of halo, hydroxy, carboxy, alkyl, alkenyl, alkynyl, haloalkyl, hydroxyalkyl, alkoxy, haloalkoxy, —CO-alkyl, -alkyl-CO-alkyl, —CO—O-alkyl, -alkyl-CO—O-alkyl, —CONH₂, —CON(alkyl)₂, —CONHalkyl, —NH₂, —N(alkyl)₂, —NHalkyl, -alkyl-CONH₂, -alkyl-CON(alkyl)₂, -alkyl-CONHalkyl, -alkyl-NH₂, -alkyl-N(alkyl)₂ and -alkyl-NHalkyl;
R¹⁵ is selected from the group consisting of: —R¹⁷, -alkyl-R¹⁷, -alkenyl-R¹⁷ and alkynyl-R¹⁷; wherein the alkyl, alkenyl or alkynyl groups are optionally substituted by one or more of: halo, hydroxy, carboxy, —CONH₂, —CON(alkyl)₂ (especially —CON(C₁₋₆alkyl)₂), —CONHalkyl (especially —CONHC₁₋₆alkyl), —NH₂, —N(alkyl)₂ (especially —N(C₁₋₆alkyl)₂) and —NHalkyl (especially —NHC₁₋₆alkyl); R¹⁵ is especially -alkyl-R¹⁷ wherein the alkyl group is optionally substituted; more especially —C₁₋₆alkyl-R¹⁷ wherein the alkyl group is optionally substituted; most especially —C₁₋₆alkyl-R¹⁷ or —C₁alkyl-R¹⁷;
R¹⁶ is hydrogen; and
R¹⁷ is aryl (especially C₆₋₁₀ aryl), cycloalkyl (especially C₃₋₁₀cycloalkyl), heterocyclyl (especially C₃₋₁₀heterocyclyl) or heteroaryl (especially C₆₋₁₀heteroaryl); more especially aryl (especially C₆₋₁₀aryl); most especially phenyl.

In one embodiment, the compound of Formula I is a compound of Formula II or a pharmaceutically acceptable salt thereof:

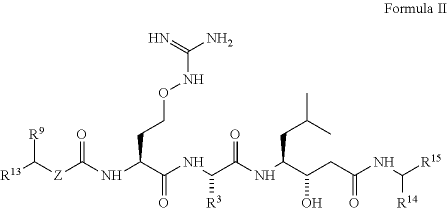

wherein R¹³, R⁹, Z, R³, R¹⁴ and R¹⁵ are as defined above.

In another embodiment, the compound of formula (I) is the compound:

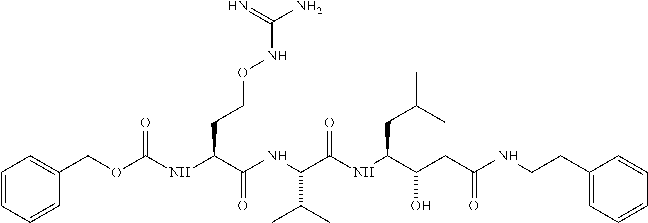 [SMILES: CC(C)C[C@H](NC(=O)[C@@H](NC(=O)[C@H](CCONC(=N)N)NC(=O)OCc1ccccc1)C(C)C)[C@@H](O)CC(=O)NCCc1ccccc1]

or a pharmaceutically acceptable salt thereof.

As used herein, the term “alkyl” refers to a straight chain or branched saturated hydrocarbon group. The alkyl group may have a specified number of carbon atoms, for example, C₁₋₇ alkyl refers to alkyl groups having 1, 2, 3, 4, 5, 6 or 7 carbon atoms in a linear or branched arrangement. Unless otherwise defined, the term “alkyl” may be C₁₋₁₂alkyl or C₁₋₆alkyl. Examples of suitable alkyl groups may include, but are not limited to, methyl, ethyl, propyl (n-propyl and i-propyl), butyl (n-butyl, i-butyl and t-butyl), n-pentyl, 2-methylbutyl, 3-methylbutyl, 4-methylbutyl, 2-ethylpropyl, n-hexyl, 2-methylpentyl, 3-methylpentyl, 4-methylpentyl, 2-ethylbutyl, 3-ethylbutyl, heptyl, octyl, nonyl, decyl, undecyl and dodecyl.

As used herein, groups such as “haloalkyl”, “alkylOH”, “alkylCO2H”, “alkylNH2” and the like means that the halo, OH, CO2H and NH2 group may be positioned on any suitable carbon of the alkyl chain. In one embodiment, for “alkylOH” the OH group is positioned at a terminal or non-terminal carbon of the alkyl group.

As used herein, the term “alkenyl” refers to a straight-chain or branched hydrocarbon group having one or more double bonds between two carbon atoms. The alkenyl group may have a specified number of carbon atoms, for example, C₂₋₇ alkenyl refers to alkenyl groups having 2, 3, 4, 5, 6 or 7 carbon atoms in a linear or branched arrangement. Unless otherwise defined, the term “alkenyl” may be C₂₋₁₂alkenyl or C₂₋₆alkenyl. Exemplary alkenyl groups may include, but are not limited to, ethenyl, propenyl, isopropenyl, butenyl, butadienyl, pentenyl, pentadienyl, hexenyl, hexadienyl, heptenyl, octenyl, nonenyl, decenyl, undecenyl and dodecenyl.

As used herein, the term “alkynyl” refers to a straight chain or branched hydrocarbon group having one or more triple bonds between two carbon atoms. The alkynyl group may have a specified number of carbon atoms, for example, C₂₋₇alkynyl refers to alkynyl groups having 2, 3, 4, 5, 6 or 7 carbon atoms in a linear or branched arrangement. Unless otherwise defined, the term “alkynyl” may be C₂₋₁₂alkynyl or C₂₋₆alkynyl. Exemplary alkynyl groups may include, but are not limited to, ethynyl, propynyl, butynyl, pentynyl, hexynyl, heptynyl, octynyl, nonynyl, decynyl, undecynyl and dodecynyl.

As used herein, the term “alkoxy” refers to the group —O-alkyl. Similarly, “haloalkoxy” refers to the group —O-alkyl, in which one or more hydrogen atoms in the alkyl group is substituted by halogen atoms. “Haloalkyl” includes perhaloalkyl groups in which all hydrogen atoms are replaced with halogen atoms.

As used herein, the term “halo” refers to a halogen atom. Exemplary halo groups include fluoro (fluorine), chloro (chlorine), bromo (bromine) and iodo (iodine); especially fluoro or chloro; most especially fluoro.

As used herein, the term “aryl” refers to any stable, monocyclic, bicyclic or tricyclic ring (or ring system) of up to 7 atoms in each ring, wherein at least one ring is aromatic. The rings may be fused to one another when more than one ring is present. The aryl group may have a specified number of carbon atoms in the ring system. For the avoidance of doubt, the term “aryl” does not encompass a group having a heteroaryl ring. For example, C₆₋₁₀ aryl refers to an aryl group with 6, 7, 8, 9 or 10 carbon atoms in the ring system (and encompasses phenyl and naphthyl groups). Exemplary aryl groups include, but are not limited to, phenyl, naphthyl, tetrahydronaphthyl, indanyl, biphenyl and binaphthyl.

As used herein, the term “heteroaryl” represents a stable monocyclic, bicyclic or tricyclic ring of up to 7 atoms in each ring, wherein at least one ring is aromatic and at least one ring contains from 1 to 4 heteroatoms selected from the group consisting of O, N and S. The rings may be fused if more than one ring is present. The heteroaryl group may also include at least one carbonyl group attached to an unsaturated carbon in the ring system. The heteroaryl group may include a specified number of carbon atoms in the ring system. For example, C6-10heteroaryl refers to a heteroaryl group with 6, 7, 8, 9 or 10 carbon atoms in the ring system, in which the ring system may include other heteroatoms such as O, S or N. Exemplary heteroaryl groups may include pyrrolyl, furanyl, thienyl, pyrazolyl, imidazolyl, triazolyl, isoxazolyl, oxazolyl, thiazolyl, isothiazolyl, oxadiazolyl, oxatriazolyl, pyridinyl, pyridazinyl, pyrimidinyl, pyrazinyl, triazinyl, azepinyl, oxepinyl, thiepinyl, diazepinyl, benzofuranyl, isobenzofuranyl, benzothienyl, indolyl, indolinyl, isoindolyl, benzimidazolyl, benzisoxazolyl, benzoxazolyl, benzothiazolyl, benzyopyranyl, benzopyranonyl, quinolinyl, tetrahydroquinolinyl, isoquinolinyl, quinazolinyl, quinoxalinyl, tetrahydroquinoxalinyl and naphthyridinyl.

As used herein, the term “cycloalkyl” refers to a saturated cyclic hydrocarbon. The cycloalkyl ring may include a specified number of carbon atoms. For example, a C₃₋₁₀cycloalkyl group includes 3, 4, 5, 6, 7, 8, 9 or 10 carbon atoms. The cycloalkyl group may include two or three rings. When there are two or three rings, each ring is linked to one or more of the other rings by sharing one or more ring atoms to thereby form a spirane or fused ring system. The cycloalkyl group may also include a carbonyl group attached to a ring carbon atom. For the avoidance of doubt, the term “cycloalkyl” does not encompass a group having an aryl, heteroaryl or heterocyclyl ring. Examples of cycloalkyl groups include, but are not limited to, cyclopropyl, cyclobutyl, cyclopentyl, cyclohexyl, cycloheptanyl and cyclooctanyl.

As used herein, the term “heterocyclyl” refers to a cycloalkyl group or cycloalkenyl group in which one or more carbon atoms have been replaced by heteroatoms independently selected from N, S and O. Between 1 and 4 carbon atoms in each ring may be replaced by heteroatoms independently selected from N, S and O. The heterocyclic group may be monocyclic, bicyclic or tricyclic. If there are two or three rings, one ring may be linked to another by sharing one or more ring atoms to thereby form a spirane or fused ring system. The heterocyclyl group may include a carbonyl group attached to an unsaturated ring carbon. The heterocyclyl group may have a specified number of ring carbon atoms, for example C₃₋₁₀heterocyclyl refers to a heterocyclyl group having 3, 4, 5, 6, 7, 8, 9 or 10 carbon atoms in the ring system. Exemplary heterocyclyl groups include tetrahydrofuranyl, tetrahydrothiophenyl, pyrrolidinyl, 2-pyrrolidonyl, pyrrolinyl, dithiolyl, 1,3-dioxolanyl, pyrazolinyl, imidazolinyl, imidazolidonyl, piperidinyl, piperazinyl, morpholinyl and tetrahydropyranyl.

The compounds of Formula I or II may be in the form of a pharmaceutically acceptable salt. Suitable pharmaceutically acceptable salts may include, but are not limited to, salts of pharmaceutically acceptable inorganic acids such as hydrochloric, sulphuric, phosphoric, nitric, carbonic, boric, sulfamic, and hydrobromic acids, or salts of pharmaceutically acceptable organic acids such as acetic, propionic, butyric, tartaric, maleic, lactic, citric, benzoic and glutamic acids. Non-pharmaceutically acceptable salts may also fall within the scope of the invention as these may be useful as intermediates in the preparation of pharmaceutically acceptable salts or during storage or transport.

The compounds of Formula I and II possess asymmetric centres. The invention may also relate to compounds in substantially pure isomeric form at one or more of said centres, for example greater than about 90% ee, such as greater than 95% ee or greater than 97% ee or greater than 99% ee. Such isomers may be prepared by asymmetric synthesis, for example using chiral intermediates, or by chiral resolution.

The compounds of Formula I and II may be synthesised employing solution or solid phase peptide chemistry procedures, as appropriately modified to include non-peptidic groups. Solution and solid phase synthetic procedures may be known to a skilled person. For example, solid phase synthetic procedures may be performed on a resin. The peptide chemistry procedures may employ either BOC or Fmoc chemistry. For example, the synthetic procedure may include successive treatments of: (i) forming an amide bond by mixing an amine with an N-protected amino acid, a coupling agent (such as HBTU (N,N,N′,N′-tetramethyl-O-(1H-benzotriazol-1-yl)uronium hexafluorophosphate)) and a base (such as diisopropylethylamine) in a polar aprotic solvent (such as dimethylformamide); and (ii) deprotecting the N-protected amino acid to provide an amine for further reaction.

The present invention may also involve combination therapies, such as the administration to a subject of a compound of the invention including a compound of Formula I or II, a peptide or mimetic of the invention or a pharmaceutically acceptable salt thereof, together with other agents or procedures for treating or preventing malaria.

The compounds of the present invention may be used as pharmaceuticals. Consequently, in a further aspect the present invention provides a pharmaceutical composition comprising a compound of the invention including a compound of Formula I or II, a peptide or mimetic of the invention or a pharmaceutically acceptable salt thereof. The pharmaceutical composition may include a pharmaceutically acceptable carrier or excipient.

The carrier(s) must be acceptable in the sense of being compatible with the other ingredients of the composition and not being deleterious to the subject.

Pharmaceutical compositions include those suitable for oral, rectal, nasal, topical (including buccal and sub-lingual), vaginal or parenteral (including intramuscular, sub-cutaneous, intrathecal and intravenous) administration or in a form suitable for administration by inhalation or insufflation. The pharmaceutical composition may be especially suitable for parenteral administration. The compound of the invention including a compound of Formula I or II, a peptide or mimetic of the invention or a pharmaceutically acceptable salt thereof may be placed with a pharmaceutically acceptable carrier or excipient in a pharmaceutical composition. Said composition may be in the form of a solid (including tablets, filled capsules, powders, capsules, suppositories, dispersible granules and pessaries), or a liquid (including solutions, suspensions, emulsions, colloids, elixirs, creams, gels and foams). In one embodiment, the pharmaceutical composition may be in the form of a sterile injectable solution for parenteral use. It is believed that the use of various carriers and excipients for pharmaceutically acceptable compounds are well known in the art. Except insofar as any conventional excipient or carrier is incompatible with the active compound, use thereof in the pharmaceutical composition is contemplated.

The nature of the pharmaceutical composition and the carrier or excipient will depend on the route of administration and the nature of the condition and the subject being treated. It is believed that the choice of a particular carrier or delivery system, and route of administration could be readily determined by a person skilled in the art. In some circumstances it may be necessary to protect the compound (in view of the amide bonds) by means known in the art, for example, by micro encapsulation. The route of administration should also be chosen such that the compound reaches its site of action.

The pharmaceutically acceptable carrier or excipient may be either a solid or a liquid. A solid carrier or excipient may act as a diluent, flavouring agent, solubilizer, lubricant, suspending agent, binder, preservative, tablet disintegrating agent or an encapsulating material. Suitable solid carriers and excipients would be known to a skilled person.

If the pharmaceutical composition is a powder, the active component and a carrier or excipient may both be finely divided powders which are mixed together.

If the pharmaceutical composition is a tablet, the active component may be mixed with a suitable amount of a carrier or excipient which has the necessary binding capacity before compaction into a tablet of the desired shape and size.

Exemplary carriers or excipients for powders and tablets may include, for example, magnesium carbonate, talc, sugar, lactose, pectin, dextrin, starch, gelatin, tragacanth, methylcellulose, a low melting wax, cocoa butter and the like.

Liquid form preparations may include, for example, water or water-propylene glycol solutions. For example, parenteral injection liquid preparations can be formulated as solutions in aqueous polyethylene glycol solution.

Liquid pharmaceutical compositions may be formulated in unit dose form. For example, the compositions may be presented in ampoules, pre-filled syringes, small volume infusion or in multi-dose containers. Such compositions may include a preservative. The compositions may also include formulatory agents such as suspending, stabilising and/or dispersing agents. The composition may also be in powder form for constitution with a suitable vehicle (such as sterile water) before use. Liquid carriers and excipients may include colorants, flavours, stabilizers, buffers, artificial and natural sweeteners, dispersants, thickeners, solubilizing agents, suspending agents and the like.

Aqueous solutions for oral use may be prepared by dissolving the active compound in water and adding colourants, thickeners, flavours, and stabilizing agents, as necessary.

Aqueous suspensions for oral use may be prepared by dispersing the active component in water with viscous material, such as natural or synthetic gums, resins, methyl cellulose or other suspending agents.

The pharmaceutical composition may also include solid-form preparations intended to be converted into a liquid form for oral administration. For topical administration to the epidermis the compounds may be formulated as an ointment, cream or lotion, or as a transdermal patch.

For oral administration, the active compound may be incorporated with carriers or excipients and used in the form of ingestible tablets, buccal or sublingual tablets, troches, capsules, elixirs, suspensions, syrups, wafers and the like. Some of these oral administration routes may have the potential to avoid liver metabolism.

The compositions may also be administered by inhalation in the form of an aerosol spray from a pressurised dispenser or container, which contains a propellant such as carbon dioxide gas, dichlorodifluoromethane, nitrogen, propane or other suitable gas or gas combination.

In another aspect, the present invention provides a method of preventing or treating malaria, the method comprising administering to a subject a pharmaceutical composition of the invention, a compound of the invention including a compound of Formula I or II, a peptide or mimetic of the invention or a pharmaceutically acceptable salt thereof.

In a further aspect, the present invention provides use of a compound of the invention including a compound of Formula I or II, a peptide or mimetic of the invention or a pharmaceutically acceptable salt thereof in the manufacture of a medicament for the treatment or prevention of malaria.

In another aspect, the present invention provides use of a compound of the invention including a compound of Formula I or II, a peptide or mimetic of the invention or a pharmaceutically acceptable salt thereof in the manufacture of a medicament for the treatment or prevention of a disease or condition associated with Plasmodium spp.

In a further aspect, the present invention provides a method of treating or preventing a disease or condition associated with Plasmodium spp., the method comprising administering to a subject in need thereof a pharmaceutical composition of the invention, a compound of Formula I or II, a peptide or mimetic of the invention or a pharmaceutically acceptable salt thereof. The “disease or condition associated with Plasmodium spp.” by a disease or condition caused or affected by a Plasmodium spp. In one embodiment, the Plasmodium spp. is P. falciparum or P. vivax. In another embodiment, said disease or condition associated with Plasmodium spp. is malaria.

In yet a further aspect, the present invention provides a method inhibiting plasmepsin V, the method comprising a step of contacting plasmepsin V with a compound of the invention including a compound of Formula I or II, a peptide or mimetic of the invention or a pharmaceutically acceptable salt thereof. In one embodiment, the plasmepsin V is derived from a Plasmodium spp., especially from P. falciparum or P. vivax. The plasmepsin V may be located in vitro or in vivo. The method may include screening of compound libraries to identify compounds that bind to plasmepsin V, and to experiments to investigate the physiology or pharmacology of plasmepsin V.

As used herein, the terms “treatment” and “prevention” are to be considered in their broadest contexts. For example, the term “treatment” does not necessarily imply that a subject is treated until full recovery. The term “treatment” includes amelioration of the symptoms of a disease or condition, or reducing the severity of a disease or condition. Similarly, “prevention” does not necessarily imply that a subject will never contract a disease or condition. “Prevention” may be considered as reducing the likelihood of onset of a disease or condition, or preventing or otherwise reducing the risk of developing a disease or condition.

An “effective amount” of a compound of the invention including a compound of Formula I or II, a peptide or mimetic of the invention or a pharmaceutically acceptable salt thereof means an amount necessary to at least partly attain a desired response, or to delay the onset or progression of the disease or condition being treated. The amount may vary depending on factors such as: the health and physical condition of the individual to whom the compound is administered, the taxonomic group of the individual to whom the compound is administered, the extent of treatment/prevention desired, the formulation of the composition, and the assessment of the medical situation. It is expected that the “effective amount” will fall within a broad range that can be determined through routine trials.

As used herein, the term “subject” may include mammals, especially humans, primates, livestock animals, laboratory test animals, companion animals and wild animals (whether captive or free). Livestock animals may include sheep, cattle, pigs, horses and donkeys. Laboratory test animals may include mice, rabbits, rats, pigs, and guinea pigs. Companion animals may include dogs and cats. In one embodiment, the subject is a human.

Throughout this specification, preferred aspects and embodiments apply, as appropriate, separately, or in combination, to other aspects and embodiments, mutatis mutandis, whether or not explicitly stated as such.

The present invention will now be described further with reference to the following examples, which are illustrative only and non-limiting.

### BRIEF DESCRIPTION OF DRAWINGS

Various embodiments of the invention will be described with reference to the following drawings. Some of the figures contain colour representations or entities. Coloured versions of the figures are available from the applicant upon request or from an appropriate patent office.

FIG. 1: Shows structures of WEHI-842 and WEHI-916 that are transition state mimetics of the RxL PEXEL motif.

FIG. 2: Shows: (A) the effects of WEHI-842 and WEHI-916 on plasmepsin V activity and parasite growth with the left panel showing inhibition of P. falciparum plasmepsin V by WEHI-842 (red) and WEHI-916 (blue) and the right panel showing inhibition of P. vivax plasmepsin V by WEHI-842 (red) and WEHI-916 (blue). For both graphs IC₅₀ data represents means±SDs for three independent experiments using the KAHRP fluorogenic substrate; (B) inhibition of P. falciparum growth with WEHI-842 and WEHI-916 with the left panel showing the inhibition of 3D7 parasites (chloroquine-sensitive) with WEHI-842 and WEHI-916 and the right panel showing results obtained with CS2, W2mef (chloroquine-resistant) and NF54 (chloroquine-sensitive). EC₅₀ data represents mean±SEMs for three independent experiments measuring P. falciparum 3D7 parasitaemia by flow cytometry following exposure to compounds in nine-point dilution series for 72 hr. Parasite survival was measured relative to vehicle-treated controls; (C) the structure of the PfEMP2-GFP chimeric protein expressed in P. falciparum. PfEMP3-GFP is exported after cleavage of the PEXEL by plasmepsin V as shown previously (Boddey J. A., et al. 2010); (D) effect of different concentrations of WEHI-842 and WEHI-916 on cleavage of the PEXEL in PfEMP3-GFP after three hours. The black arrow shows the uncleaved protein that accumulates in the ER due to inhibition of plasmepsin V and the blue arrow shows the plasmepsin V cleaved band. The lower panel shows anti-HSP70 as a loading control; and (E) effect of WEHI-842 and WEHI-916 (10 μM) on cleavage of the PEXEL in PfEMP3-GFP over time of incubation. The lower panel again shows anti-HSP70 as a loading control.

FIG. 3: Shows: (A) inhibition of PfEMP3-GFP processing by plasmepsin V measured by radiolabelling. Parasites were incubated with WEHI-842 and WEHI-916 (10 μM) for 3 hours and then proteins labeled with ³⁵S-Met for 10 min. PfEMP3-GFP was immunoprecipitated and visualized by SDS-PAGE and autoradiography. The black arrow points to uncleaved PfEMP3-GFP, the red arrow points to the signal peptidase cleaved PfEMP3-GFP, the blue arrow points to PEXEL cleaved PfEMP3-GFP as described previously Sleebs, B. E., et al. (2014a). The histogram shows densitometry quantitation of each band as a proportion compared to the total protein pool detected in each lane; (B) inhibition of PfEMP3-GFP processing by plasmepsin V by WEHI-842 is reversible. Parasites were incubated with WEHI-842 (10 μM) for three hours, proteins labeled with ³⁵S-Met for 10 min, and parasites were then incubated in normal medium lacking ³⁵S-Met for 30 and 60 min as a cold chase. PfEMP3-GFP was immunoprecipitated and visualized by SDS-PAGE and autoradiography. The black arrow points to uncleaved PfEMP3-GFP, the red arrow points to signal peptidase cleaved PfEMP3-GFP, the blue arrow points to PEXEL cleaved PfEMP3-GFP. The histogram shows densitometry quantitation of each band as a proportion compared to the total protein pool detected in each lane; (C) a schematic showing the assay of soluble proteins exported to the cytosol of P. falciparum-infected erythrocytes. Tetanolysin mediates pores in the erythrocyte membrane allowing release of soluble proteins; and (D) that export of PfEMP3-GFP into P. falciparum-infected erythrocytes was blocked by WEHI-842. The top panel assays PfEMP3-GFP exported to the cytosol of P. falciparum-infected erythrocytes over time. The histogram shows quantitation of PfEMP3-GFP immunoprecipitated from the tetanolysin supernatant at each time point. The middle panel shows that no aldolase has leaked from the parasite during tetanolysin treatment. The bottom two panels show that approximately equal amounts of PfEMP3-GFP and aldolase were present in the cells just prior to immunoprecipitation.

FIG. 4: Shows a model of the crystal structure of plasmepsin V in complex with inhibitor WEHI-842 with (A) and (B) respectively showing front and side views of surface plots; and (C) and (D) respectively showing equivalent orientations in ribbon form. WEHI-842 (green) is bound to the substrate-binding site of P. vivax plasmepsin V with the flap over the binding site (brown) in a closed position. Free Cys140 and disulfide bonded Cys amino acids are represented as spheres (yellow).

FIG. 5: Shows a comparison of the disulfide-bond architectures found in the enzyme domains of selected aspartic proteases. Cys residue numbers for P. vivax (Pv) plasmepsin V are shown but sequence separations are not shown to scale. Numbers 1-14 represents the relative positions of Cys amino acids in P. vivax plasmepsin V for comparison to other aspartic proteases. The addition or subtraction of numbers or letters represents a shift in position of other cysteine amino acids found in other aspartic proteases relative to those in the enzyme domain of P. vivax plasmepsin V. PDB identifier codes for each structure are shown in parentheses. The disulfide connectivity for P. falciparum (Pf) PMV, T. gondii (Tg) Aspv, Phytophthora infestans (Pi) AP and oomycete NEP1 (for necrosis and ethylene-inducing peptide1) are predicted based on structure alignment models.

FIG. 6: Shows a structural alignment of P. vivax plasmepsin V with P. falciparum plasmepsin II. In particular: (A) shows a model of the P. vivax plasmepsin V crystal structure aligned with a model of the P. falciparum plasmepsin II crystal structure (PDB: 1LF4). The top view looks directly into the substrate-binding site, while the bottom view is a 90⁰ clockwise rotation of the image showing a side view of the substrate-binding site. The NAP1 insert sequence (green) in P. vivax plasmepsin V is located towards the top of the P. vivax structure and the helix-turn-helix motif (yellow) is found on the bottom edge of the molecule. Disulfide bonds in both structural elements are shown in red; (B) shows the models of the P. vivax plasmepsin V crystal structure and the P. falciparum plasmepsin II crystal structure aligned and coloured by the root mean square deviation (“RMSD”). The RMSD measures the distances in A between the C-alpha atoms of two aligned residues. Dark blue colouring represents good alignment, while higher deviations are shown progressively through green to red. Residues not used for alignment are coloured white; and (C) is an enlarged view of the substrate-binding sites of the models of the P. vivax plasmepsin V crystal structure and the P. falciparum plasmepsin II crystal structure shown in (B) showing the level of structural similarity.

FIG. 7: Shows a model of the protein-ligand interactions between the substrate-binding site of P. vivax plasmepsin V and WEHI-842 from the crystal structure of P. vivax plasmepsin V in complex with WEHI-842. In particular: (A) shows a magnified view of the substrate-binding site of P. vivax plasmepsin V in complex with WEHI-842. The main chain atoms of residues involved in interactions with WEHI-842 are represented as spheres (pink), while side chains involved in interactions are displayed. H₂O molecules 1 and 2, which are also involved in stabilising the complex, are both shown as spheres (red). The position of the Ile78 and Val188 side chains are shown to assist in orientation of residues shown below in (C); (B) shows a simplified 2D schematic of (A) showing the location of the S₁-S₃ pockets in the complex; and (C) shows a magnified view of the S₁ pocket (rear view) showing the hydrophobic residues Ile78, Val188, Phe180 and Tyr139 (blue and red mesh) tightly encapsulating the P₁ leucine (green) group from WEHI-842.

FIG. 8: Shows the preparation of recombinant P. vivax and P. falciparum plasmepsin V for activity assays and structural studies. Each protein was prepared using the same protocol. Plasmepsin V fusion proteins were secreted into and harvested from insect cell medium, affinity purified using anti-flag resin and the fusion tag removed using TEV protease. The enzyme domain for each plasmepsin V was obtained in high purity from the digest using SEC. In particular: (A) shows SDS-PAGE analysis of the removal of the fusion from recombinant P. vivax plasmepsin V enzyme domain. Lane 1=P. vivax plasmepsin V fusion protein prior to TEV cleavage, Lane 2=TEV protease, Lane 3=P. vivax plasmepsin V/TEV digest mixture and Lane 4=control digest (no P. vivax plasmepsin V fusion protein added). Lanes 1-4 were electrophoresed in the presence of reducing (RD) sample buffer. Lanes 5-8 are replicas of Lanes 1-4 except samples were electrophoresed in the presence of non-reducing (NR) sample buffer. Removal of the fusion tag occurs at completion and the band equivalent to the fusion tag is seen at approximately 20 kDa; (B) shows SDS-PAGE analysis of the SEC purification of the P. vivax plasmepsin V enzyme domain from the TEV digest. Labels 1, 2 and 3 represent key fractions from the elution profile and PAGE analysis has shown that high molecular weight multimers (1) and the low molecular weight fusion tag (3) have been removed from P. vivax plasmepsin V enzyme domain (2) using SEC. All recombinant forms of P. falciparum/P. vivax plasmepsin V were found to elute with retention times equivalent to the expected monomeric size of these proteins; and (C) shows SDS-PAGE analysis of the final purified forms of the recombinant plasmepsin V enzyme domains (fusion tag removed) used for the majority of the enzymatic assays and crystallization trials. Approximately 3-5 μg of protein/lane was electrophoresed in the presence of RD or NR sample buffer.

FIG. 9: Shows a sequence alignment of P. vivax and P. falciparum plasmepsin V and activity of the enzyme. In particular: (A) shows partial sequence alignments for comparison of the N-terminal regions of P. vivax and P. falciparum plasmepsin V; (B) shows protease activity of P. falciparum plasmepsin V using the KAHRP PEXEL pentamer as wild type and with mutations of RL>2A, R>K and L>I; (C) shows protease activity of P. vivax plasmepsin V using the KAHRP PEXEL pentamer as wild type and with mutations of RL>2A, R>K and L>I; and (D) shows abolition of enzyme activity for P. vivax plasmepsin V that has a D>N mutation in the active site.

FIG. 10: Show the Michaelis-Menten enzyme kinetics of P. falciparum and P. vivax plasmepsin V. In particular, (A) and (B) respectively show Michaelis-Menten curves showing the rate of cleavage (relative fluorescence units per min) of increasing concentrations of fluorogenic KAHRP PEXEL peptide by plasmepsin V after 17 and 33 min with P. falciparum plasmepsin V and P. vivax plasmepsin V; (C) and (D) respectively show Burk-Lineweaver plots of the velocity of plasmepsin V as a function of the fluorogenic KAHRP PEXEL substrate concentration with P. falciparum plasmepsin V and P. vivax plasmepsin V. The data was used to derive Kₘ values; (E) and (F) respectively show the Kinetics of cleavage of the KAHRP fluorogenic substrate at varying concentrations over time with P. falciparum plasmepsin V and P. vivax plasmepsin V; and (G) shows P. falciparum plasmepsin V and P. vivax plasmepsin V kinetic values derived from the Michaelis-Menten plots (MM) and Burk-Lineweaver plots (BL).

FIG. 11: Shows: (A) a representative sensorgram showing direct binding kinetics of WEHI-916 to P. vivax plasmepsin V; and (B) a representative sensorgram showing direct binding kinetics of WEHI-842 to P. vivax plasmepsin V. Binding to P. vivax plasmepsin V at each concentration is illustrated by coloured curves with fit curves overlaid in black.

FIG. 12: Shows the effect of WEHI-842 on global protein synthesis in P. falciparum. In particular: (A) shows purified magnet-purified trophozoites treated with DMSO or WEHI-842 (2.5, 5 or 10 μM) for 3 hours prior to labeling parasite proteins with ³⁵S-methionine/cysteine for 15 mins show no defect in protein synthesis. HSP70 levels were examined by immunoblot as a loading and viability control (middle panel). The effect on PfEMP3-GFP processing was also examined by immunoblot (bottom panel). Images were obtained using the same membrane; and (B) shows a schematic of PfEMP3-GFP showing the positions of processing.

FIG. 13: Shows an alignment of P. vivax plasmepsin V (“Pv pmv”) and P. falciparum plasmepsin II (Pf pmII) sequences and secondary structural elements. This alignment was prepared using the online ESPript program located at http://espript.ibcp.fr (Robert, X. & Gouet, P., 2014). The sequence corresponding to the regions of the enzyme domains that have crystal structures have been compared. Although P. vivax plasmepsin v and P. falciparum plasmepsin II have poor sequence homology most of the secondary structural elements are maintained in their individual 3D structures. The PDB file reference used for P. falciparum plasmepsin II sequence information was 1LF4.

FIG. 14: Shows structural features for P. vivax plasmepsin V in complex with WEHI-842. In particular: (A) shows a putty model of the crystal structure of P. vivax plasmepsin V illustrating the differences in B-factors within the structure. Increased B-factors are shown as increased thickness and colour transition (blue to orange); and (B) shows various schematics detailing the surface electrostatic potential for P. vivax plasmepsin V. The top LHS image shows a face of the structure of the molecule enabling a full frontal view of the substrate-binding site. The top RHS image is rotated 90° clockwise showing a face of the molecule with a side view of the substrate-binding site. There is a large area of negative electrostatic potential predicted to be adjoining the edge of the substrate-binding site and at the bottom of the molecule. The bottom RHS image shows the back face of the molecule with the substrate-binding site facing into the page. The bottom LHS shows the other side surface of P. vivax plasmepsin V and is predicted to have an extensive area of positive electrostatic surface potential.

FIG. 15: Shows: (A) a sequence alignment of P. falciparum with P. vivax plasmepsin V through the region in which the X-ray crystallographic structure was determined. Asterisks on the underside of rows indicate residues in P. vivax plasmepsin V that are involved in interactions with WEHI 842 inhibitor. Colored lines atop of a row indicate specific structural features found in P. vivax plasmepsin V (green=NEP1 insert, red=loop region with no observed electron density and yellow=Helix-Loop-Helix region; (B) a schematic showing potential interactions between conserved residues proposed to lie in the substrate-binding site of P. falciparum plasmepsin V and WEHI-842.

### KEY TO SEQUENCE LISTING

SEQ ID NO: 1—Amino acid sequence of plasmepsin V from P. falciparum.

SEQ ID NO: 2—Amino acid sequence of plasmepsin V from P. vivax.

SEQ ID NO: 3—Nucleotide sequence encoding recombinant P. vivax plasmepsin V with an N-terminal fusion tag comprising a FLAG tag, a SUMO domain and a TEV protease cleavage site.

SEQ ID NO: 4—Nucleotide sequence encoding recombinant P. vivax plasmepsin V including KpnI and XhoI restriction sites for insertion into pTriex2 expression vector.

SEQ ID NO: 5—Amino acid sequence of expressed recombinant P. vivax plasmepsin V with the uncleaved N-terminal fusion tag comprising a FLAG tag, a SUMO domain and a TEV protease cleavage site.

SEQ ID NO: 6—Amino acid sequence of recombinant P. vivax plasmepsin V following cleavage of the N-terminal fusion tag comprising a FLAG tag and a SUMO domain at the TEV cleavage site (the “plasmepsin V polypeptide chain”).

SEQ ID NO: 7—Amino acid sequence of a peptide from knob-associated histidine-rich protein (“KAHRP”) containing the PEXEL sequence (RTLAQ).

SEQ ID NO: 8—Amino acid sequence of a variant KAHRP peptide containing a mutated PEXEL sequence (KTLAQ).

SEQ ID NO: 9—Amino acid sequence of another variant KAHRP peptide containing a mutated PEXEL sequence (RTIAQ).

### DETAILED DESCRIPTION

Unless defined otherwise, all technical and scientific terms used herein have the same meaning as commonly understood by one of ordinary skill in the art (e.g. in molecular biology, biochemistry, structural biology, and/or computational biology). Standard techniques are used for molecular and biochemical methods (see generally, Sambrook et al., 2001, Ausubel et al. 1999 and Green and Sambrook, 2012, which are incorporated herein by reference) and chemical methods.

In the present specification and claims, the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

As used herein the term “homologue” means a protein having at least 30% amino acid sequence identity with plasmepsin V and/or portions thereof. Preferably, the percentage identity is 40% or 50%, more preferably 60% or 70% and most preferably 80% or 90%. A 95% or above identity is most particularly preferred such as 95%, 96%, 97%, 98%, 99% or 100%.

As used herein the term “derivative” means plasmepsin V that displays the biological activity of wild-type plasmepsin V, characterised by the replacement of at least one amino acid from the wild-type sequence or the modification of one or more of the naturally-occurring amino acids.

Crystals and Crystal Structure of WEHI-842 in Complex with Plasmepsin V

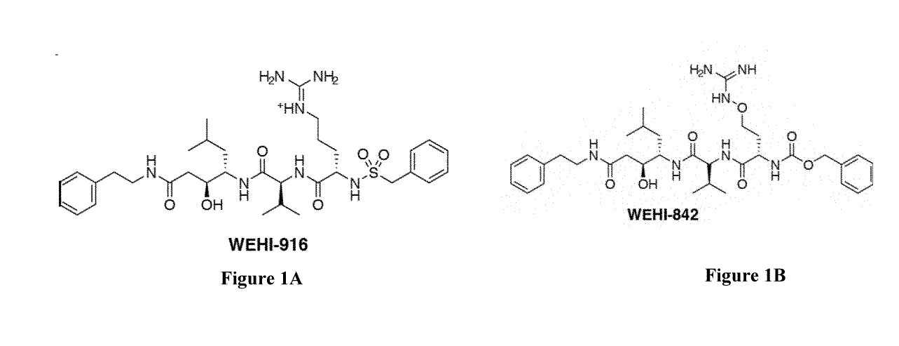

The present invention provides a crystal comprising a P. vivax plasmepsin V construct (SEQ ID NO: 6) in complex with WEHI-842 (see FIG. 1B). The construct includes residues 35 to 476 of P. vivax plasmepsin V (SEQ ID NO: 2), and does not include the C-terminal membrane anchor.

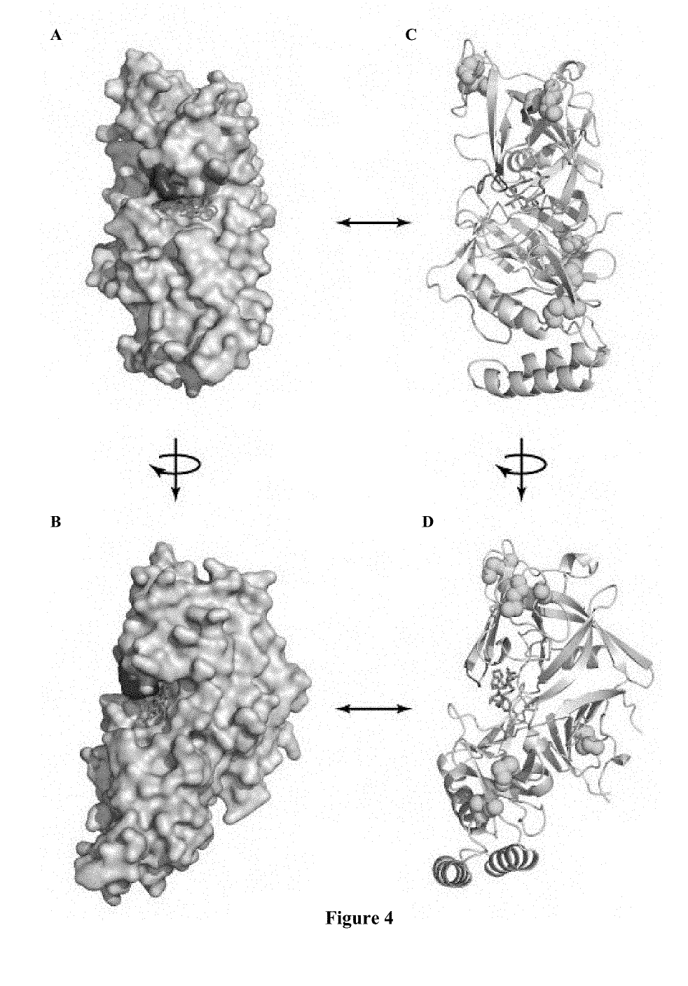

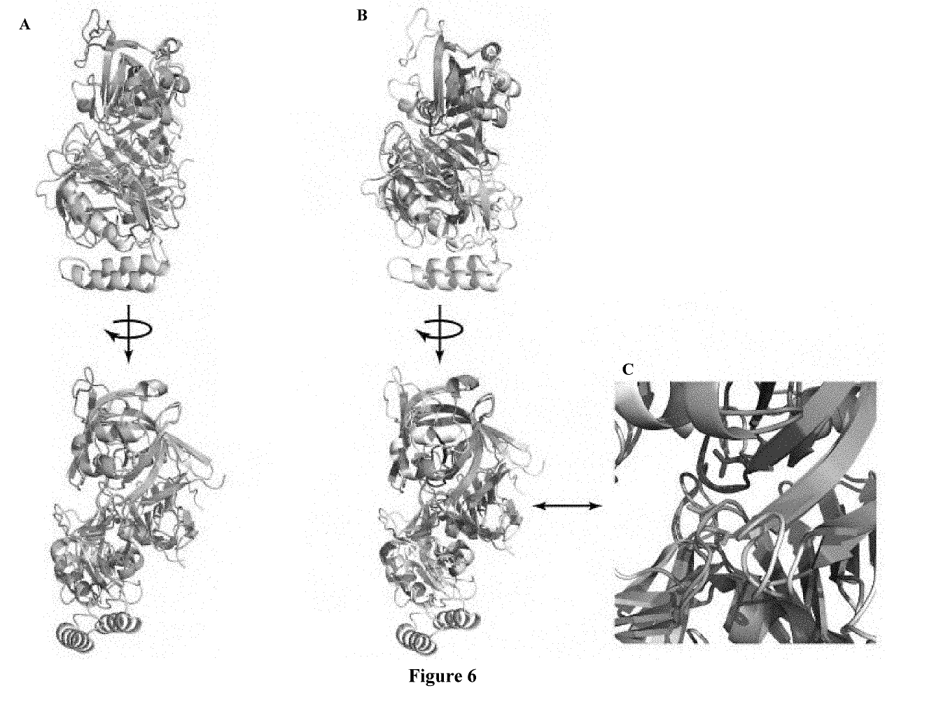

The crystal structure of P. vivax plasmepsin V complexed with WEHI-842 is presented in FIGS. 4 and 6. The crystal structure reveals a canonical aspartyl protease fold including an enzyme domain comprised of a crescent-shaped and predominantly 3-sheet core about the substrate-binding site. The enzyme domain includes N- and C-terminal subdomains that contact each other along the bottom of the substrate-binding site that contains the active site aspartates (Asp80 and Asp313, according to SEQ ID NO: 2). The amino and carboxyl ends of the plasmepsin V polypeptide are assembled into a characteristic six-stranded interdomain P-sheet, which serves to anchor the N- and C-terminal subdomains together. The N-terminal subdomain further includes a distinctive β-hairpin loop structure, known as a “flap”, which lies perpendicular over the substrate-binding site and interacts with the bound WEHI-842.

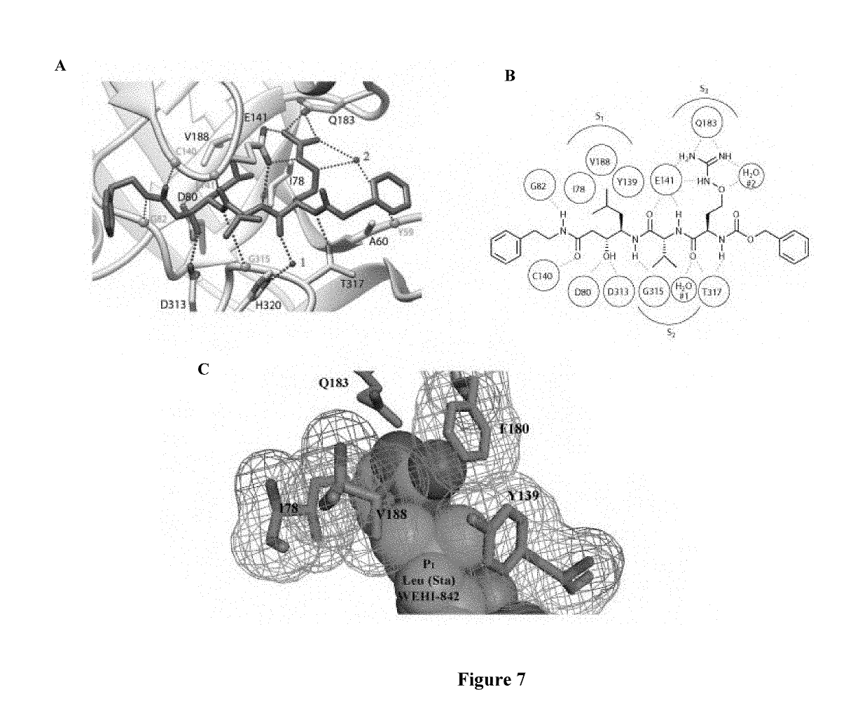

WEHI-842 is seen to interact with the substrate-binding site and the flap of plasmepsin V. The details of these interactions are presented in FIG. 7.

The structure also reveals two features that are not present in aspartyl proteases, namely a NAP1 insert consisting of 17 amino acids, including four cysteine residues, and a helix-turn-helix motif. The latter motif is posited to likely be important in plasmepsin V's function in export after cleavage of effector substrates.

The NAP1 insert consisting of 17 amino acids including four cysteine residues is located in the N-terminal subdomain and has been found to be similar to that found in plant aspartic proteases such as nepenthesin 1. The insert in nepenthesin 1 has been named the ‘nepenthesin 1-type aspartyl protease (NAP1) fold (Athauda S. B., et al. 2004) and is considered to play a role in functional regulation of napenthesin 1 (Athauda S. B., et al. 2004).

The helix-turn-helix motif consists of 43 amino acids and appears to be unique to plasmepsin V including orthologous proteases of Plasmodium spp.

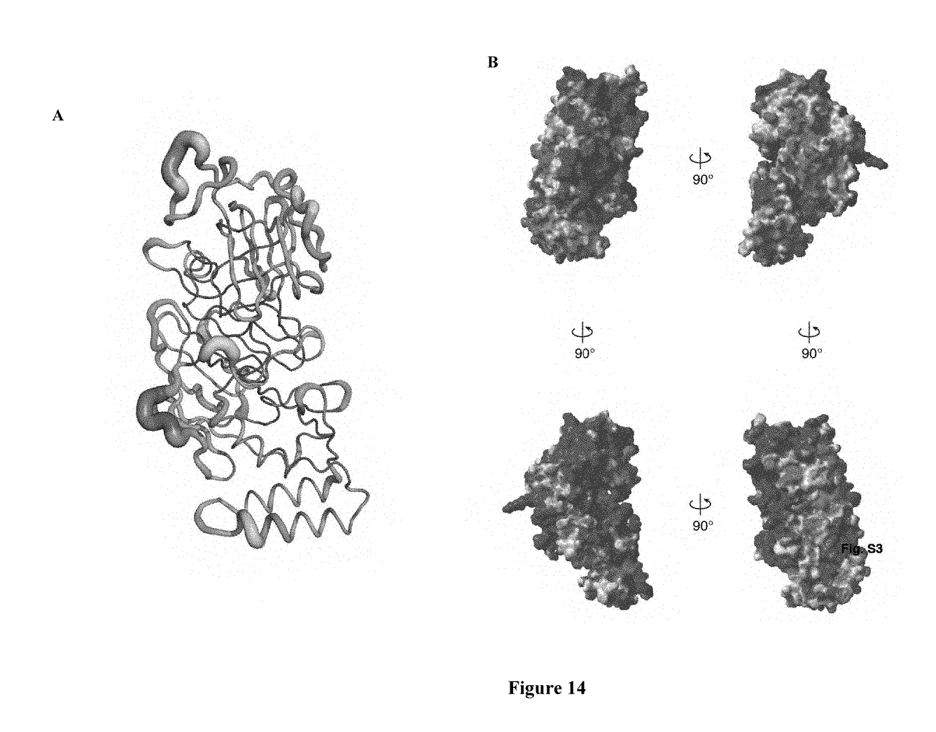

The b-factor putty schematic shown in FIG. 14 reveals that most loop regions in the structure generally have higher B-factors indicating greater flexibility, as expected. However, the flap located over the substrate-binding site was relatively well ordered, consistent with its interaction with WEHI-842. P. vivax plasmepsin V is predicted to have a predominantly positive surface charge at neutral pH with significant patches of negative surface charge associated at one corner of the substrate-binding site and another in the vicinity of the helix-turn-helix motif at the bottom of the structure.

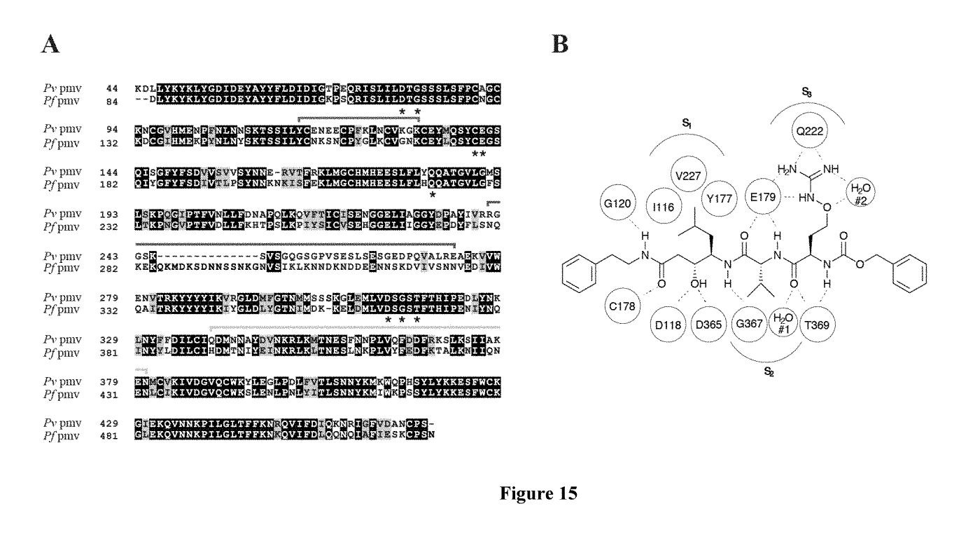

The loop region between R241 to E272 (according to SEQ ID NO:2) in P. vivax plasmepsin V had poor electron density and its structure could not be determined. Nevertheless, the structure for P. vivax plasmepsin V indicates that these residues would be located on an opposite side of the molecule to the substrate-binding site and presumably would not interact with effector proteins. Plasmepsin V from other Plasmodium spp. also contained regions of similar size at this location and this loop is observed to have poor conservation of sequence between species (see FIG. 15). In the alignment, Plasmodium orthologues of P. vivax plasmepsin V have 55-85% identity, 76-91% similarity and <3% gap in their comparative sequences (http://ncbi.nlm.nih.gov/entrez/query.fcgi). Other Apicomplexa, plant pathogens, and plants have enzymes related to plasmepsin V (e.g. Toxoplasma gondii, Theileria orientalis, Babesia equi, Phytophthora infestans and Nepenthes gracilis) with sequence identities, similarities and sequence gaps of <35%, <50% and up to 20%, respectively. Other members of the plasmepsin family of aspartyl proteases in Plasmodium spp. (such as plasmepsin II, VI, IX and X) exhibit very low sequence similarity with plasmepsin V, consistent with their diverse functional differences.

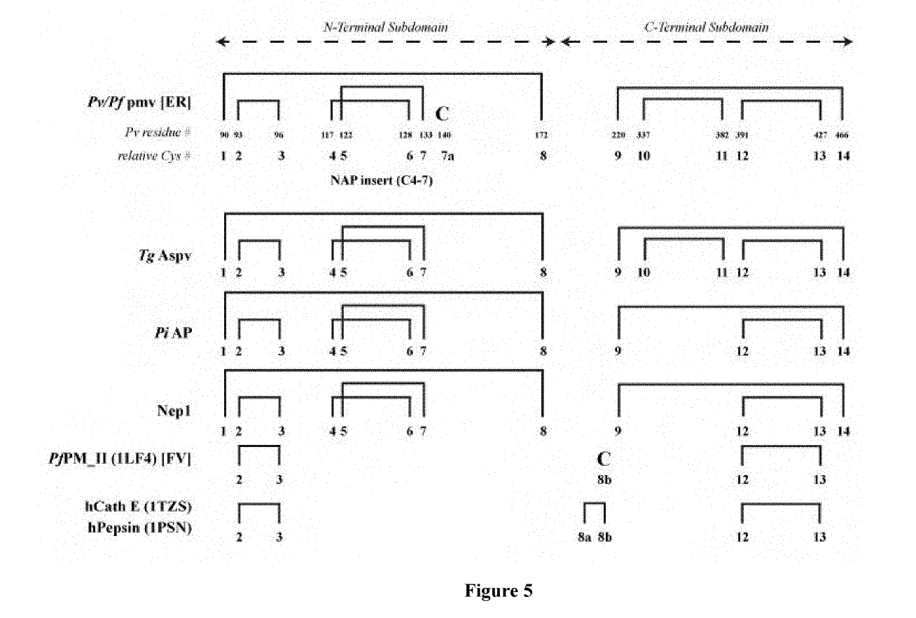

The enzyme domain of P. vivax plasmepsin V contains fifteen cysteine residues forming seven disulfide linkages, with four of these located in the N-terminal subdomain and three in the C-terminal subdomain (see FIG. 5). Although P. vivax plasmepsin V has a pepsin-like family fold, the disulfide-bond architecture is more complex than for the majority of members within this enzyme group (Kay J., et al. 2011). For example, structures of pepsin and cathepsin E have three disulfide bonds and the food vacuole plasmepsins I, II and IV of P. falciparum have lost one of these three disulfides. Recently, a sub-family of plant aspartic proteases with high cysteine content have been phylogenetically clustered, however, no structural information was available (Kay J., et al. 2011). Plasmepsin V was also found to locate within the same clade which contained plant and fungal aspartic acid proteases, with the majority being type I integral membrane proteins. The crystal structure for P. vivax plasmepsin V, used in conjunction with previously reported alignments suggests a similar disulfide-bond architecture for this group of enzymes and represents the first structure for this unusual group of aspartic proteases of Sub-family AIB.

A C1-C8 disulfide-linkage spans the N-terminal subdomain; nestled within this region is a conserved pepsin-like C2-C3 disulfide bond and the NAP1 insert consisting of 17 amino acids (Athauda, S. B., et al. 2004) including four cysteine residues with disulfide linkages between C4-C6 and C5-C7. The P. vivax plasmepsin V NAP1 insert linkage pattern differs to the C4-C7 and C5-C6 architecture previously predicted using sequence alignments and known structures of pepsin-like aspartic proteases (Kay J., et al. 2011; Athauda, S. B., et al. 2004). The unpaired cysteine residue (C7a) located adjacent to the archetypal tyrosine in the flap above the substrate-binding site in the structure was not observed in other Apicomplexans or in closely related plant/fungal aspartic proteases and appears to be unique to Plasmodium spp. (see FIGS. 5 and 6).

In the C-terminal subdomain the C9-C14 linkage stabilises the orientation of the substrate-binding site by securing the six-stranded interdomain β-sheet (seated behind the binding site) to the region of the polypeptide chain leading toward the membrane anchor point of the protein. The C10-C11 linkage in P. vivax plasmepsin V tethers each end of a helix-turn-helix motif to the structure. This structural element is present in Plasmodium orthologues but not in other Apicomplexa, plant or fungal homologues of plasmepsin V or other plasmepsin family proteases, where it is usually replaced by a small, unstructured loop, which may be tethered by the C10-C11 linkage. The C12-C13 linkage found in P. vivax plasmepsin V was also observed in pepsin-like enzymes and appears to be conserved in other Apicomplexan homologues of plasmepsin V. Previous studies with Phytophthora spp. have suggested that similarly located cysteine residues may be involved in intermolecular disulfide bonds (Kay J., et al. 2011). However, sequence alignments within the same studies reveal these residues to be positioned such that they could potentially participate in the C12-C13 linkage found in P. vivax plasmepsin V.

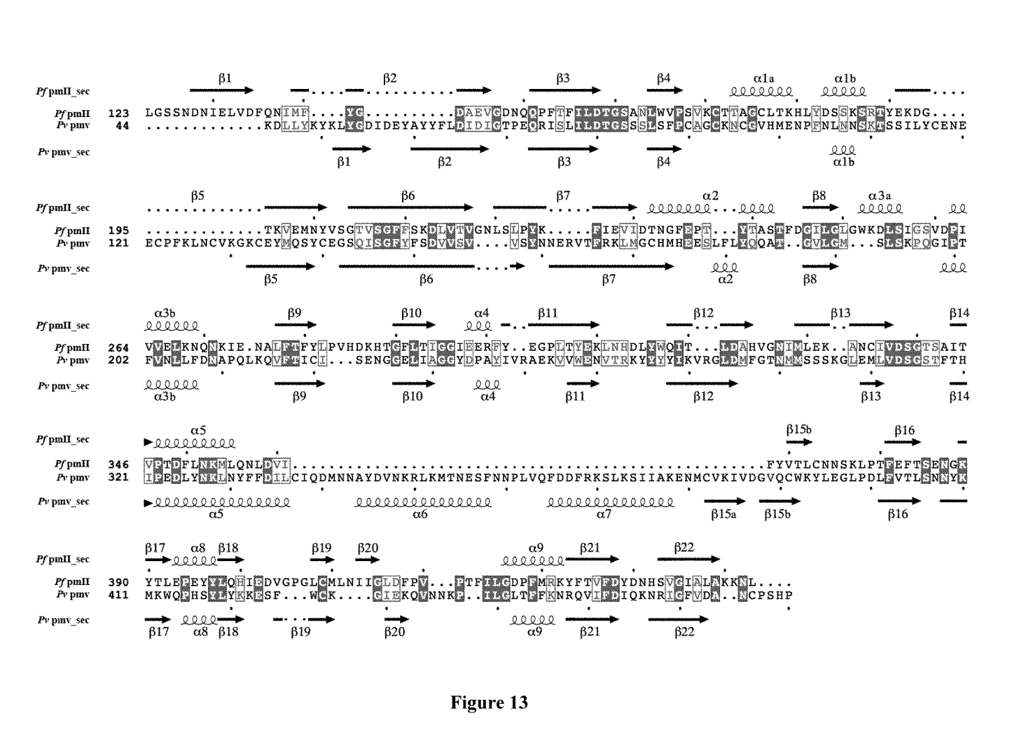

A sequence and secondary structural alignment between P. vivax plasmepsin V and P. falciparum plasmepsin II, another member of the plasmepsin family that is involved in haemoglobin digestion, shows low sequence homology but a high level of preservation of secondary structural elements throughout the enzyme domains (see FIG. 13). Alignment of both structures (see FIG. 6A) shows good conservation of the fold within the core and substrate-binding site regions that can be visualised when the aligned structures are coloured according to the root mean square deviation (RMSD) (see FIGS. 6B and 6C). The structural similarity decreases towards the extremities of these molecules where more mobile regions or structural differences such as the NAP1 insert and the helix-turn-helix motif of plasmepsin V occur (see FIG. 6B).

In P. vivax plasmepsin V the NAP1 insert forms a surface loop (Tyr116-Gly121), (coloured green in FIG. 6A) (Athauda, S. B., et al. 2004) which was not observed in the structure of P. falciparum plasmepsin II. There were also minor changes in the alignment of other structural elements in the vicinity of the inserted loop (see FIG. 6B). The NAP1 insert is also not seen in other members of the broader plasmepsin family such as plasmepsin VI, IX and X. An alignment of the NAP1 insert sequences for orthologues of plasmepsin V in Plasmodium spp. shows this region to be highly conserved but the conservation of sequence is lost from other Apicomplexan orthologues and related plant enzymes. Intriguingly, the flap that sits above the substrate-binding site in the structure of P. vivax plasmepsin V appears to be intricately associated with the NAP1 insert. The flap sequence, which contains unpaired Cys140, is highly conserved in orthologues of plasmepsin V in Plasmodium spp. The sequence homology in the flap remains high in other Apicomplexan orthologues except their flap regions do not contain an unpaired cysteine residue. One of the disulfide bonds (i.e., C5-C7) within the NAP1 insert tethers this loop to the N-terminal β-strand within the flap. It has been suggested previously (Athauda, S. B., et al. 2004) that the NAP1 insert plays a role in functional regulation of nepenthesin 1. The P. vivax plasmepsin V structure reveals the flap position may be influenced by an interaction with another protein through the NAP1 insert (see FIG. 14). Primary candidates for this would be PEXEL effectors as they enter to dock for processing and require the flap to be sufficiently open for the PEXEL motif of a large polypeptide to insert into the substrate-binding site. Sequence alignments of plasmepsin V indicate this proposed “molecular gate” for PEXEL access could be conserved throughout Apicomplexa and related plant/fungal enzymes. Although the short pro-sequence for P. vivax plasmepsin V was not included for structure determination, its location is predicted to be oriented away from the substrate-binding site leaving this enzyme possibly in a continuous active state (Boddey, J. A., et al. 2010; Russo I., et al. 2010; Klemba, M. & Goldberg, D. E. 2005).

The helix-turn-helix motif is another key feature of P. vivax plasmepsin V and is conserved only within orthologues of Plasmodium spp. (see FIG. 14). The helix-turn-helix motif (Ile338-Met381, coloured yellow in FIG. 6A) is also absent from other crystalized plasmepsins, including P. falciparum plasmepsin II. An overlay shows that their structures align poorly in the regions N-terminal (helix 5) and C-terminal (the β-sheet incorporating the β15a strand) to the Cys337-Cys382 (C10-C11) tethering point in P. vivax plasmepsin V (see FIGS. 6A and 6B). This can be explained by the way the helix-turn-helix motif is stabilised internally and within the adjoining areas of the plasmepsin V molecule. These amphipathic helices are held strongly together in an antiparallel orientation by hydrophobic residues orientated toward each other along the internal face of the motif, while the 315a strand is involved in disulfide bond tethering of the motif (see FIG. 13). The hydrophilic residues lining the outside edges of the helix-turn-helix motif are highly conserved in plasmepsin V orthologues across Plasmodium spp. (see FIG. 15). The conservation of this structural element and surrounding features suggests it plays an important functional role.

As shown in FIG. 7A, the N-terminal carbamate moiety of WEHI-842 protrudes outside the substrate-binding site and does not directly influence the binding affinity of the inhibitor (Gazdik, M., et al. 2015; Sleebs, B. E., et al. 2014b). The protein-ligand interactions primarily involve residues in close proximity to the two catalytic Asp residues (Asp80 and Asp313, according to SEQ ID NO: 2) and those located in the flap directly above the substrate-binding site. The two catalytic Asp residues of plasmepsin V can be seen to interact with the statine hydroxyl functionality that mimics the transitional-state intermediate formed during the cleavage of the peptide bond, these interactions explain the mechanism of plasmepsin V inhibition by WEHI-842.

The oxo-guanidinium ion of WEHI-842 lies deep within the S3 pocket of plasmepsin V and participates in multiple interactions that anchor it to the substrate-binding site. The carboxylic acid moiety of Glu141 of the flap forms a “side-on” salt bridge with the guanidinium ion while the carbonyl group on the Gln183 side chain interacts with two hydrogen atoms located at the distal end of the same ion (see FIGS. 7B and 7C). The guanidinium ion is further stabilised via hydrogen bonding to a water molecule (H2O #2 in FIG. 7A) that also interacts with the main chain carbonyl of Tyr59. These interactions of the guanidine side-chain explain why the PEXEL Arg residue is important for plasmepsin V activity.

The P1 Leu in the PEXEL has been shown to be important for binding affinity of plasmepsin V substrates and inhibitors (Sleebs, B. E., et al. 2014a; Sleebs, B. E., et al. 2014b; Boddey, J. A., et al. 2013). The structure reveals that this residue occupies the S1 pocket and is tightly encapsulated within the hydrophobic environment created by the juxtaposition of residues Ile78, Tyr139 and Val188 (see FIG. 7B). Hence, even substitution by the structural isomer Ile has limited tolerance in this pocket (Sleebs, B. E., et al. 2014a; Sleebs, B. E., et al. 2014b; Boddey, J. A., et al. 2013). The majority of carbonyl and amide groups along the length of the main chain of WEHI-842 are involved in H-bonding with surrounding amino acids and solvent molecules (see, e.g. H20 #1 in FIG. 7A) creating an extensive network of interactions anchoring the inhibitor across the substrate-binding site (see FIGS. 7B and 7C). The unpaired Cys140 residue found in the flap above the substrate-binding site interacts, via its main chain amide group, with the statine carbonyl on WEHI-842. Although the Cys140 side chain orientates toward the inhibitor there was no obvious interaction/function for the thiol in this structure.

For orthologues of Plasmodium spp. aligned, the residues lining the surface of the substrate binding site are essentially identical except for two alternative residues observed in the S5 position for P. falciparum, P. vinckei, and P. berghei plasmepsin V (not shown). Such high levels of conservation indicate that high affinity inhibitors identified for plasmepsin V should be effective against most if not all Plasmodium spp. and suggests animal models can be utilised for in vivo kinetic studies. The cavity surface for the orthologues from other Apicomplexa and nepenthesin 1 show variations in sequence around some of the key interactive residues and various substrate binding pockets throughout the substrate-binding site, suggesting inhibitors optimised for use against Plasmodium spp. may not be as active against other related aspartyl proteases.

Analysis of the crystal structure reveals that not all cavity space has been utilised in this complex. The ability for naturally occurring peptides to efficiently fill this space may be limited, whereas non-peptide-based inhibitors may offer greater scope in geometry and physico-chemical properties that could lead to improved affinities for plasmepsin V. For example, the P₂ position on WEHI-842 has been found optimal for Val but Ile and Leu can be tolerated in this position with minimum changes to affinity. It is apparent that the S₂ pocket is only partially filled by the Val residue of WEHI-842. Furthermore, the main cavity of the P₃ pocket is largely filled by the canavanine side chain, however, a smaller yet equally deep cavity also exists on the floor of this pocket that is not utilised by this inhibitor. Finally, the pockets on the edge of the substrate binding cavity, such as S₁′, S₂′, S₄ and S₅ may offer additional opportunities to improve the affinities of future inhibitors to plasmepsin V.

As used herein, the term “crystal” means a structure (such as a three-dimensional (3D) solid aggregate) in which the plane faces intersect at definite angles and in which there is a regular structure (such as an internal structure) of the constituent chemical species. The term “crystal” refers in particular to a solid physical crystal form such as an experimentally prepared crystal.

Crystals according to the invention may be prepared using any plasmepsin V polypeptide containing the enzyme domain, including the N- and C-terminal subdomains, and lacking the C-terminal membrane anchor point (SEQ ID NOs: 2, 5 and 6). Typically, the plasmepsin V polypeptide (SEQ ID NO: 6) comprises residues 35 to 476, according to SEQ ID NO: 2, or the equivalent thereof together with any post-translational modifications of these residues such as N- or O-linked glycosylation.

In a preferred embodiment, the plasmepsin V polypeptide is from P. vivax (SEQ ID NOs: 2, 5 and 6). However, the plasmepsin V polypeptide may be obtained from other species, such as, e.g., P. falciparum (SEQ ID NO: 1).

Crystals may be constructed with wild-type plasmepsin V polypeptide sequence or variants thereof, including allelic variants and naturally occurring mutations as well as genetically engineered variants. Typically, variants have at least 95% or 98% sequence identity with a corresponding wild-type plasmepsin V polypeptide.

Crystals according to the invention may preferably be prepared using inhibitor WEHI-842 (see FIG. 1B). In some embodiments, crystals may be constructed with variants, derivatives or pharmaceutically acceptable salts of WEHI-842.

Optionally, the crystal of plasmepsin V in complex with WEHI-842 may comprise one or more compounds which bind to plasmepsin V and/or WEHI-842, or otherwise are soaked into the crystal or co-crystallised with plasmepsin V and/or WEHI-842. Such compounds include ligands or small molecules, which may be candidate pharmaceutical agents intended to modulate the interaction between plasmepsin V and biological substrates.

The production of crystals of plasmepsin V in complex with WEHI-842 is described below.

In a preferred embodiment, a crystal of plasmepsin V in complex with WEHI-842 of the invention has the atomic coordinates as set forth in Appendix I.

As used herein, the term “atomic coordinates” or “set of coordinates” refers to a set of values which define the position of one or more atoms with reference to a system of axes. It will be understood by those skilled in the art that the atomic coordinates may be varied, without affecting significantly the accuracy of models derived therefrom. Thus, although the invention provides a very precise definition of a preferred atomic structure, it will be understood that minor variations are envisaged and the claims are intended to encompass such variations.

It will be understood that any reference herein to the atomic coordinates or subset of the atomic coordinates shown in Appendix I shall include, unless specified otherwise, atomic coordinates having a root mean square deviation of backbone atoms of not more than 1.5 Å, preferably not more than 1 Å, when superimposed on the corresponding backbone atoms described by the atomic coordinates shown in Appendix I.

The following defines what is intended by the term “root mean square deviation (‘RMSD’)” between two data sets. For each element in the first data set, its deviation from the corresponding item in the second data set is computed. The squared deviation is the square of that deviation, and the mean squared deviation is the mean of all these squared deviations. The root mean square deviation is the square root of the mean squared deviation.

Preferred variants are those in which the RMSD of the x, y and z coordinates for all backbone atoms other than hydrogen is less than 1.5 Å (preferably less than 1 Å, 0.7 Å or less than 0.3 Å) compared with the coordinates given in Appendix I. It will be readily appreciated by those skilled in the art that a 3D rigid body rotation and/or translation of the atomic coordinates does not alter the structure of the molecule concerned.

In a highly preferred embodiment, the crystal has the atomic coordinates as shown in Appendix I.

The present invention also provides a crystal structure of the substrate-binding site of plasmepsin V comprising the N- and C-terminal subdomains of plasmepsin V, or regions or parts thereof.

The atomic coordinates obtained experimentally for: amino acids 44 to 240 and 273 to 470 of P. vivax plasmepsin V and WEHI-842 are shown in Appendix I. However, a person skilled in the art will appreciate that a set of atomic coordinates determined by X-ray crystallography is not without standard error. Accordingly, any set of structure coordinates for plasmepsin V, optionally in complex with WEHI-842, that has a root mean square deviation of protein backbone atoms of less than 0.75 Å when superimposed (using backbone atoms) on the atomic coordinates listed in Appendix I shall be considered identical.

A structure that “substantially conforms” to a given set of atomic coordinates is a structure wherein at least about 50% of such structure has an RMSD of less than about 1.5 Å for the backbone atoms in secondary structure elements in each domain, and more preferably, less than about 1.3 Å for the backbone atoms in secondary structure elements in each domain, and, in increasing preference, less than about 1.0 Å, less than about 0.7 Å, less than about 0.5 Å, and most preferably, less than about 0.3 Å for the backbone atoms in secondary structure elements in each domain.

In a more preferred embodiment, a structure that substantially conforms to a given set of atomic coordinates is a structure wherein at least about 75% of such structure has the recited RMSD value, and more preferably, at least about 90% of such structure has the recited RMSD value, and most preferably, about 100% of such structure has the recited RMSD value.

In an even more preferred embodiment, the above definition of “substantially conforms” can be extended to include atoms of amino acid side chains. As used herein, the phrase “common amino acid side chains” refers to amino acid side chains that are common to both the structure which substantially conforms to a given set of atomic coordinates and the structure that is actually represented by such atomic coordinates.

As used herein, the term “enzyme domain” refers to the core enzymatic aspartyl protease fold of plasmepsin V lacking the C-terminal membrane anchor, and typically comprising residues 35 to 470 of P. vivax plasmepsin V as given in SEQ ID No: 2.

As used herein, the term “N-terminal subdomain” refers an N-terminal region of plasmepsin V that forms a part of the enzyme domain and which together with the C-terminal subdomain and the six-stranded interdomain β-sheet define the substrate-binding site of plasmepsin V.

As used herein, the term “C-terminal subdomain” refers to a C-terminal region of plasmepsin V that forms a part of the enzyme domain and which together with the N-terminal subdomain and the six-stranded interdomain β-sheet define the substrate-binding site of plasmepsin V.

As used herein, the term “six-stranded interdomain β-sheet” refers to an N-terminal region of the plasmepsin V polypeptide and a C-terminal region of the plasmepsin V polypeptide located before the absent membrane anchor that are assembled into a six-stranded interdomain 3-sheet structural motif, which serves to anchor the N- and C-terminal subdomains together.

As used herein, the term “substrate-binding site” for plasmepsin V means the regions of plasmepsin V involved in binding a substrate or inhibitor (also known as a “binding cleft”). The substrate-binding site is formed between the N- and C-terminal subdomains, which are together anchored to the six-stranded interdomain β-sheet to form a crescent-shaped enzyme domain. The substrate-binding site contains the catalytic dyad, Asp80 and Asp313 as given in SEQ ID NO: 2.

As used herein, the term the “flap” refers to a β-hairpin structure in the N-terminal subdomain of plasmepsin V previously described in the literature on aspartyl proteases as interacting with substrate or inhibitors in the substrate-binding site (Baldwin, E. T., et al. 1993), and comprising amino acids 139 to 142 as given in SEQ ID No: 2.

As used herein, the term “NAP1 insert” for plasmepsin V refers to a sequence insert comprising residues 116 to 132 as given in SEQ ID: No 2, which form a surface loop in the N-terminal subdomain.

As used herein, the term “helix-turn-helix motif” refers in plasmepsin V to a structural motif including two c-helices joined by a short loop and located in the C-terminal subdomain. The helix-turn-helix motif comprises amino acids 338 to 381 as given in SEQ ID No: 2.

### Manipulation of the Atomic Coordinates

It will be appreciated that a set of atomic coordinates for one or more polypeptides is a relative set of points that define a shape in three dimensions. Thus, it is possible that an entirely different set of coordinates could define a similar or identical shape. Moreover, slight variations in the individual coordinates will have little effect on overall shape.

The variations in coordinates may be generated due to mathematical manipulations of the atomic coordinates. For example, the atomic coordinates set forth in Appendix I could be manipulated by crystallographic permutations of the atomic coordinates, fractionalisation of the atomic coordinates, integer additions or subtractions to sets of the structure coordinates, inversion of the atomic coordinates, or any combination thereof.

Alternatively, modification in the crystal structure due to mutations, additions, substitutions, and/or deletions of amino acids, or other changes in any of the components that make up the crystal could also account for variations in atomic coordinates.

Various computational analyses are used to determine whether a molecular complex or a portion thereof is sufficiently similar to all or parts of the structure of plasmepsin V in complex with WEHI-842 described above. Such analyses may be carried out in current software applications, such as the Sequoia program (Bruns et al., 1999).

The Molecular Similarity program permits comparisons between different structures, different conformations of the same structure, and different parts of the same structure.

Comparisons typically involve calculation of the optimum translations and rotations required such that the root mean square deviation of the fit over the specified pairs of equivalent atoms is an absolute minimum. This number is given in Angstroms (“Å”).

Accordingly, atomic coordinates of plasmepsin V comprising a substrate-binding site in complex with WEHI-842 of the present invention include atomic coordinates related to the atomic coordinates listed in Appendix I by whole body translations and/or rotations. Accordingly, RMSD values listed above assume that at least the backbone atoms of the structures are optimally superimposed which may require translation and/or rotation to achieve the required optimal fit from which to calculate the RMSD value.

A three dimensional structure of a plasmepsin V polypeptide or a region thereof and/or a three dimensional structure of WEHI-842 or a region or portion thereof which substantially conforms to a specified set of atomic coordinates can be modelled by a suitable modelling computer program such as MODELLER (Sali & Blundell, 1993), using information, for example, derived from the following data: (1) the amino acid sequence of plasmepsin V and/or the sequence of WEHI-842; (2) the amino acid sequence of the related portion(s) of the protein represented by the specified set of atomic coordinates having a three dimensional configuration; and (3) the atomic coordinates of the specified three dimensional configuration. A three dimensional structure of plasmepsin V and/or a three dimensional structure of WEHI-842 which substantially conforms to a specified set of atomic coordinates can also be calculated by a method such as molecular replacement, which is described in detail below.

Atomic coordinates are typically loaded onto a machine-readable medium for subsequent computational manipulation. Thus models and/or atomic coordinates are advantageously stored on machine-readable media, such as magnetic or optical media and random-access or read-only memory, including tapes, diskettes, hard disks, CD-ROMs and DVDs, flash memory cards or chips, servers and the internet. The machine is typically a computer.

The atomic coordinates may be used in a computer to generate a representation, e.g. an image of the three-dimensional structure of plasmepsin V in complex with WEHI-842 which can be displayed by the computer and/or represented in an electronic file.

The atomic coordinates and models derived therefrom may also be used for a variety of purposes such as drug discovery, biological reagent (binding protein) selection and X-ray crystallographic analysis of other protein crystals.

### Molecular Replacement

The structure coordinates of plasmepsin V in complex with WEHI-842, such as those set forth in Appendix I, or a subset thereof, can also be used for determining the three-dimensional structure of a molecular complex which contains at least N- and/or C-terminal regions of plasmepsin V. In particular, structural information about another crystallised molecular complex may be obtained. This may be achieved by any of a number of well-known techniques, including molecular replacement.

Methods of molecular replacement are generally known by those of skill in the art (generally described in Brunger, 1997; Navaza & Saludjian, 1997; Tong & Rossmann, 1997; Bentley, 1997; Lattman, 1985; Rossmann, 1972; McCoy, 2007).

Generally, molecular replacement involves the following steps. X-ray diffraction data are collected from the crystal of a crystallised target structure. The X-ray diffraction data are transformed to calculate a Patterson function. The Patterson function of the crystallised target structure is compared with a Patterson function calculated from a known structure (referred to herein as a search structure). The Patterson function of the search structure is rotated on the target structure Patterson function to determine the correct orientation of the search structure in the crystal. A translation function is then calculated to determine the location of the search structure with respect to the crystal axes. Once the search structure has been correctly positioned in the unit cell, initial phases for the experimental data can be calculated. These phases are necessary for calculation of an electron density map from which structural differences can be observed and for refinement of the structure. Preferably, the structural features (e.g., amino acid sequence, conserved di-sulphide bonds, and beta-strands or beta-sheets) of the search molecule are related to the crystallised target structure.

The electron density map can, in turn, be subjected to any well-known model building and structure refinement techniques to provide a final, accurate structure of the unknown (i.e., target) crystallised molecular complex (e.g. see Jones et al., 1991; Brünger et al., 1998).

Obtaining accurate values for the phases, by methods other than molecular replacement, is a time-consuming process that involves iterative cycles of approximations and refinements and greatly hinders the solution of crystal structures. However, when the crystal structure of a protein containing at least a homologous portion has been solved, the phases from the known structure provide a satisfactory starting estimate of the phases for the unknown structure.

By using molecular replacement, all or part of the structure coordinates of plasmepsin V in complex with WEHI-842 provided herein (and set forth in Appendix I) can be used to determine the structure of a crystallised molecular complex whose structure is unknown more rapidly and more efficiently than attempting to determine such information ab initio. This method is especially useful in determining the structure of plasmepsin V.

The structure of any portion of any crystallised molecular complex that is sufficiently homologous to any portion of P. vivax plasmepsin V can be solved by this method, such as, e.g., P. falciparum plasmepsin V.

Such structure coordinates are also particularly useful to solve the structure of crystals of plasmepsin V co-complexed with a variety of molecules, such as chemical entities. For example, this approach enables the determination of the optimal sites for the interaction between chemical entities, and the interaction of candidate plasmepsin V inhibitors.

All of the complexes referred to above may be studied using well-known X-ray diffraction techniques and may be refined against 0.8-3.5 Å resolution X-ray data to an R value of about 0.25 or less using computer software, such as X-PLOR (Yale University, distributed by Molecular Simulations, Inc.; see Brünger, 1996) or Phenix (Adams, P. D., et al. 2010), for example. This information may thus be used to optimize known inhibitors, and more importantly, to design new or improved plasmepsin V inhibitors.

### Target Sites for Compound Identification, Design or Screening

The three-dimensional structure of the substrate-binding site and the flap of plasmepsin V in complex with WEHI-842 provided by the present invention (Appendix I) can be used to identify potential target binding sites in the substrate-binding site and/or the flap of P. vivax plasmepsin V and/or P. falciparum plasmepsin V (i.e., to identify those regions of the substrate-binding site and/or the flap of P. vivax plasmepsin V and/or P. falciparum plasmepsin V involved in and important to the binding of WEHI-842) as well as in methods for identifying and/or designing other compounds which can interact with the substrate-binding site and/or the flap of P. vivax plasmepsin V and/or P. falciparum plasmepsin V, e.g., potential inhibitors of P. vivax plasmepsin V and/or P. falciparum plasmepsin V.

In one embodiment, the target binding site may comprise portions of the molecular surface of the substrate-binding site and the flap. In a preferred embodiment, the target binding site may comprise one or more residues from residues 44 to 240 and/or amino acids 273 to 470 of P. vivax plasmepsin V as given in SEQ ID NO: 2. In a more preferred embodiment, the target binding site includes one or more residues selected from the group consisting of Tyr59, Ala60, Ile78, Asp80, Gly82, Tyr139, Cys140, Glu141, Phe180, Gln183, Val188, Asp313, Gly315 and Thr317 of P. vivax plasmepsin V as given in SEQ ID NO: 2.

Design, Selection, Fitting and Assessment of Chemical Entities that Bind Plasmepsin V

Using a variety of known modelling techniques, the crystal structure of the present invention can be used to produce a model of one or more regions of the structure shown to interact with WEHI-842.

As used herein, the term “modelling” includes the quantitative and qualitative analysis of molecular structure and/or function based on atomic structural information and interaction models. The term “modelling” includes conventional numeric-based molecular dynamic and energy minimisation models, interactive computer graphic models, modified molecular mechanics models, distance geometry and other structure-based constraint models.

Molecular modelling techniques can be applied to the atomic coordinates of plasmepsin V in complex with WEHI-842, or at least parts, or regions thereof to derive a range of 3D models and to investigate the structure of the substrate-binding sites, the flap and any other bindings sites, such as the binding sites of monoclonal antibodies, non-immunoglobulin binding proteins and inhibitory peptides.

These techniques may also be used to screen for or design small and large chemical entities which are capable of binding to plasmepsin V, preferably within the substrate-binding site, to, for example, inhibit or at least reduce cleavage of the PEXEL motif of effector proteins to inhibit or at least reduce the activity of P. falciparum and/or P. vivax plasmepsin V, inhibit or at least reduce protein export and optionally be lethal to P. falciparum and/or P. vivax growth.

Such modelling methods are to design or select chemical entities that possess stereochemical complementary to the substrate-binding site of P. falciparum and/or P. vivax plasmepsin V and/or to at least a portion of the flap of P. falciparum and/or P. vivax plasmepsin V with which WEHI-842 interact. By “stereochemical complementarity” it is meant that the compound or a portion thereof makes a sufficient number of energetically favourable contacts with the substrate-binding site and/or the flap so as to have a net reduction of free energy on binding to the substrate binding site and/or the flap.

Such modelling methods may also be used to design or select chemical entities that possess stereochemical similarity to the substrate-binding site surface of WEHI-842 and/or to the portions of WEHI-842 that interact with at least a portion of the flap of P. falciparum and/or P. vivax plasmepsin V. By “stereochemical similarity” it is meant that the compound or portion thereof makes about the same number of energetically favourable contacts with plasmepsin V as WEHI-842 makes as determined by the crystal structure of WEHI-842 in complex with plasmepsin V as set out by the coordinates shown in Appendix I.

Stereochemical complementarity is characteristic of a molecule that matches intra-site surface residues lining the substrate-binding site and in the flap as enumerated by the coordinates set out in Appendix I or a subset thereof. By “match” it is meant that the identified portions interact with the surface residues, for example, via hydrogen bonding or by non-covalent Van der Waals and Coulomb interactions (with surface or residue) which promote desolvation of the molecule within the site, in such a way that retention of the molecule at the binding site is favoured energetically.

It is preferred that the stereochemical complementarity is such that the compound has a KD for the substrate-binding site and/or the flap of less than 10⁻⁵M, more preferably less than 10⁻⁶M and yet more preferably 10⁻⁷M. In a most preferred embodiment, the KD value is less than 10⁻⁸ M or better yet less than 10⁻⁹ M.

Chemical entities which are complementary to the shape and electrostatics or chemistry of the substrate-binding site and/or the flap characterised by amino acids positioned at atomic coordinates set out in Appendix I will be able to bind to the substrate-binding site and/or the flap, and when the binding is sufficiently strong, substantially inhibit or at least reduce the interaction of P. falciparum and/or P. vivax plasmepsin V with biological target molecules, such as effector proteins with the PEXEL motif.

It will be appreciated that it is not necessary that the complementarity between chemical entities and the substrate-binding site and/or the flap or similarity between the chemical entities and biological target molecules such as effector proteins with the PEXEL motif need extend over all residues of the substrate-binding site and/or the flap or the target molecule in order to inhibit or mimic binding of a molecule or complex that naturally interacts with plasmepsin V.

A number of methods may be used to identify chemical entities possessing stereochemical complementarity to the substrate-binding site of P. falciparum and/or P. vivax plasmepsin V and/or to at least a portion of the flap of P. falciparum and/or P. vivax plasmepsin V with which WEHI-842 interacts. For instance, the process may begin by visual inspection of the entire P. vivax substrate-binding site, or the equivalent region in P. falciparum plasmepsin V, on the computer screen based on the coordinates in Appendix I generated from the machine-readable storage medium. Alternatively, selected fragments or chemical entities may then be positioned in a variety of orientations, or docked, within the substrate-binding site of P. falciparum and/or P. vivax plasmepsin V or relative to the at least a portion of the flap of P. falciparum and/or P. vivax plasmepsin V with which WEHI-842 interacts in a manner similar to WEHI-842 and plasmepsin V as defined above.

Modelling software that is well known and available in the art may be used (Guida, 1994). These include Discovery Studio (Accelrys Software Inc., San Diego), SYBYL (Tripos Associates, Inc., St. Louis, Mo., 1992), Maestro (Schrödinger LLC, Portland), MOE (Chemical Computing Group Inc., Montreal, Canada). This modelling step may be followed by energy minimization with standard molecular mechanics force fields such as AMBER (Weiner et al., 1984), OPLS (Jorgensen and Tirado-Rives, 1988) and CHARMM (Brooks et al., 1983). In addition, there are a number of more specialized computer programs to assist in the process of selecting the binding moieties of this invention.

Specialised computer programs may also assist in the process of selecting fragments or chemical entities. These include, inter alia:
1. GRID (Goodford, 1985). GRID is available from Molecular Discovery Ltd., Italy;
2. AUTODOCK (Goodsell & Olsen, 1990). AUTODOCK is available from Scripps Research Institute, La Jolla, Calif.;
3. DOCK (Kuntz et al., 1982). DOCK is available from University of California, San Francisco, Calif.;
4. GLIDE (Friesner et al., 2004). GLIDE is available from Schrödinger LLC, Portland; and
5. GOLD (Cole et al., 2005). GOLD is available from The Cambridge Crystallographic Data Centre, Cambridge, UK.

Once suitable chemical entities or fragments have been selected, they can be assembled into a single compound. In one embodiment, assembly may proceed by visual inspection of the relationship of the fragments to each other on the three-dimensional image displayed on a computer screen in relation to the structure coordinates of the substrate-binding site of P. vivax plasmepsin V and/or to at least a portion of the flap of P. vivax plasmepsin V with which WEHI-842 binds. This is followed by manual model building using software such as Discovery Studio, Maestro, MOE or Sybyl. Alternatively, fragments may be joined to additional atoms using standard chemical geometry.

The above-described evaluation process for chemical entities may be performed in a similar fashion for chemical compounds.

Useful programs to aid one of skilled in the art in connecting the individual chemical entities or fragments include:
1. CAVEAT (Bartlett et al., 1989). CAVEAT is available from the University of California, Berkeley, Calif.; and
2. GANDI (Day and Caflisch, 2008). GANDI is available from the University of Zurich.

Other molecular modelling techniques may also be employed in accordance with this invention, see, e.g., Cohen et al. (1990) and Navia & Murcko (1992).

There are two preferred approaches to designing a molecule according to the present invention that complement the stereochemistry of the substrate-binding site of plasmepsin V and/or to at least a portion of the flap of plasmepsin V with which WEHI-842 binds. The first approach is to in silico directly dock molecules from a three-dimensional structural database, to the target binding site, using mostly, but not exclusively, geometric criteria to assess the goodness-of-fit of a particular molecule to the site. In this approach, the number of internal degrees of freedom (and the corresponding local minima in the molecular conformation space) is reduced by considering only the geometric (hard-sphere) interactions of two rigid bodies, where one body (the active site) contains “pockets” or “grooves” that form binding sites for the second body (the complementing molecule).

Flexibility of plasmepsin V, can be incorporated into the in silico screening by the application of multiple conformations of plasmepsin V. The multiple conformations of plasmepsin V can be generated from the coordinates listed in Appendix I or a subset thereof computationally by use of molecular dynamics simulation or similar approaches.

This approach is illustrated by Kuntz et al. (1982) and Ewing et al. (2001), the contents of which are hereby incorporated by reference, whose algorithm for ligand design is implemented in a commercial software package, DOCK version 4.0, distributed by the Regents of the University of California and further described in a document, provided by the distributor, which is entitled “Overview of the DOCK program suite” the contents of which are hereby incorporated by reference. Pursuant to the Kuntz algorithm, the shape of the cavity in which WEHI-842 fits may be defined as a series of overlapping spheres of different radii. One or more extant databases of crystallographic data, such as the Cambridge Structural Database System (The Cambridge Crystallographic Data Centre, Cambridge, U.K.), the Protein Data Bank maintained by the Research Collaboratory for Structural Bioinformatics (Rutgers University, N.J., U.S.A.), LeadQuest (Tripos Associates, Inc., St. Louis, Mo.), Available Chemicals Directory (Symyx Technologies Inc.), and the NCI database (National Cancer Institute, U.S.A) is then searched for molecules which approximate the shape thus defined.

Molecules identified on the basis of geometric parameters, can then be modified to satisfy criteria associated with chemical complementarity, such as hydrogen bonding, ionic interactions and van der Waals interactions. Different scoring functions can be employed to rank and select the best molecule from a database (see, e.g., Bohm & Stahl, 1999). The software package FlexX, marketed by Tripos Associates, Inc. (St. Louis, Mo.) is another program that can be used in this direct docking approach (see Rarey et al., 1996).

The second preferred approach entails an assessment of the interaction of respective chemical groups (“probes”) with the active site at sample positions within and around the site, resulting in an array of energy values from which three-dimensional contour surfaces at selected energy levels can be generated. The chemical-probe approach to ligand design is described, for example, by Goodford, (1985), the contents of which are hereby incorporated by reference, and is implemented in several commercial software packages, such as GRID (product of Molecular Discovery Ltd., Italy).

Pursuant to this approach, the chemical prerequisites for a site-complementing molecule are identified at the outset, by probing the active site with different chemical probes, e.g., water, a methyl group, an amine nitrogen, a carboxyl oxygen, or a hydroxyl. Favoured sites for interaction between the active site and each probe are thus determined, and from the resulting three-dimensional pattern of such sites a putative complementary molecule can be generated. This may be done either by programs that can search three-dimensional databases to identify molecules incorporating desired pharmacophore patterns or by programs which use the favoured sites and probes as input to perform de novo design. Suitable programs for determining and designing pharmacophores include CATALYST (Accelrys Software, Inc), and CERIUS2, DISCO (Abbott Laboratories, Abbott Park, Ill.; distributed by Tripos Associates Inc.).

The pharmacophore can be used to screen in silico compound libraries/three-dimensional databases, using a program such as CATALYST (Accelrys Software, Inc) and Sybyl/3DB Unity (Tripos Associates, Inc., St. Louis, Mo.).

Databases of chemical structures are available from a number of sources including Cambridge Crystallographic Data Centre (Cambridge, U.K.), Molecular Design, Ltd., (San Leandro, Calif.), Tripos Associates, Inc. (St. Louis, Mo.), Chemical Abstracts Service (Columbus, Ohio), the Available Chemical Directory (Symyx Technologies, Inc.), the Derwent World Drug Index (WDI), BioByteMasterFile, the National Cancer Institute database (NCI), Medchem Database (BioByte Corp.), and the Maybridge catalogue.

De novo design programs include LUDI (Accelrys Software Inc., San Diego, Calif.), Leapfrog (Tripos Associates, Inc.), and LigBuilder (Peking University, China).

Once an entity or compound has been designed or selected by the above methods, the efficiency with which that entity or compound may bind to plasmepsin V can be tested and optimised by computational evaluation. For example, a compound that has been designed or selected to function as plasmepsin V binding compound must also preferably traverse a volume not overlapping that occupied by the binding site when it is bound to native plasmepsin V. An effective plasmepsin V binding compound must preferably demonstrate a relatively small difference in energy between its bound and free states (i.e., a small deformation energy of binding). Thus, the most efficient plasmepsin V binding compound should preferably be designed with a deformation energy of binding of not greater than about 10 kcal/mole, preferably, not greater than 7 kcal/mole.

A compound designed or selected as binding to plasmepsin V may be further computationally optimised so that in its bound state it would preferably lack repulsive electrostatic interaction with the target protein.

Such non-complementary (e.g., electrostatic) interactions include repulsive charge-charge, dipole-dipole and charge-dipole interactions. Specifically, the sum of all electrostatic interactions between the compound and the protein when the compound is bound to plasmepsin V, preferably make a neutral or favourable contribution to the enthalpy of binding.

Once a plasmepsin V binding compound has been optimally selected or designed, as described above, substitutions may then be made in some of its atoms or side groups to improve or modify its binding properties. Generally, initial substitutions are conservative, i.e., the replacement group will have approximately the same size, shape, hydrophobicity and charge as the original group. It should, of course, be understood that components known in the art to alter conformation should be avoided. Such substituted chemical compounds may then be analysed for efficiency of fit to plasmepsin V by the same computer methods described in detail above.

Specific computer software is available in the art to evaluate compound deformation energy and electrostatic interaction. Examples of programs designed for such uses include: Gaussian 03, (Frisch, Gaussian, Inc., Pittsburgh, Pa.); GAMESS (Gordon et al., Iowa State University); Jaguar (Schrödinger LLC, Portland); AMBER, version 9.0 (Case et al, University of California at San Francisco); CHARMM (Accelrys Software, Inc., San Diego, Calif.); and GROMACS version 4.0 (van der Spoel et al.).

The screening/design methods may be implemented in hardware or software, or a combination of both. However, preferably, the methods are implemented in computer programs executing on programmable computers each comprising a processor, a data storage system (including volatile and non-volatile memory and/or storage elements), at least one input device, and at least one output device. Program code is applied to input data to perform the functions described above and generate output information. The output information is applied to one or more output devices, in known fashion. The computer may be, for example, a personal computer, microcomputer, or workstation of conventional design.

Each program is preferably implemented in a high level procedural or object-oriented programming language to communicate with a computer system. However, the programs can be implemented in assembly or machine language, if desired. In any case, the language may be compiled or interpreted language.

Each such computer program is preferably stored on a storage medium or device (e.g., ROM or magnetic diskette) readable by a general or special purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

### Compounds

Compounds of the present invention include those designed and/or identified using a screening method of the invention, those encompassed by the compounds of Formulas I and II described above and those which are capable of recognising and binding to the substrate-binding site of plasmepsin V and/or interacting with the flap of plasmepsin V as defined above.

Compounds capable of recognising and binding to the substrate-binding site of plasmepsin V and/or interacting with the flap of plasmepsin V may be produced using (i) a screening method based on use of the atomic coordinates corresponding to the 3D structure of the substrate-binding site and/or the flap in complex with WEHI-842; or (ii) a screening method based on the use of the atomic coordinates corresponding to the 3D structure of WEHI-842 in complex with plasmepsin V. Alternatively, compounds may be identified by screening against a specific target molecule which is indicative of the capacity to bind to the substrate-binding site and/or the flap of plasmepsin V.

The candidate compounds and/or compounds identified or designed using a method of the present invention may be any suitable compound, synthetic or naturally occurring, preferably synthetic. In one embodiment, a synthetic compound selected or designed by the methods of the invention preferably has a molecular weight equal to or less than about 5000, 4000, 3000, 2000, 1000 or 500 daltons. A compound of the present invention is preferably soluble under physiological conditions.

The compounds may encompass numerous chemical classes, though typically they are organic molecules, preferably small organic compounds having a molecular weight of more than 50 and less than about 2,500 daltons, preferably less than 1,500, more preferably less than 1,000 and yet more preferably less than 500. Such compounds can comprise functional groups necessary for structural interaction with proteins, particularly hydrogen bonding, and typically include at least an amine, carbonyl, hydroxyl or carboxyl group, preferably at least two of the functional chemical groups. The compound may comprise cyclical carbon or heterocyclic structures and/or aromatic or polyaromatic structures substituted with one or more of the above functional groups. Compounds can also comprise biomolecules including peptides, saccharides, fatty acids, steroids, purines, pyrimidines, derivatives, structural analogues, or combinations thereof.

Compounds may include, for example: (1) peptides such as soluble peptides, including Ig-tailed fusion peptides and members of random peptide libraries (see, e.g., Lam et al., 1991; Houghten et al., 1991) and combinatorial chemistry-derived molecular libraries made of D- and/or L-configuration amino acids; (2) phosphopeptides (e.g., members of random and partially degenerate, directed phosphopeptide libraries, see, e.g., Songyang et al., 1993); (3) antibodies (e.g., polyclonal, monoclonal, humanized, anti-idiotypic, chimeric, and single chain antibodies as well as Fab, (Fab)2′, Fab expression library and epitope-binding fragments of antibodies); (4) non-immunoglobulin binding proteins such as but not restricted to avimers, DARPins and lipocalins; (5) nucleic acid-based aptamers; and (6) small organic and inorganic molecules.

Ligands can be obtained from a wide variety of sources including libraries of synthetic or natural compounds. Synthetic compound libraries are commercially available from, for example, Maybridge Chemical Co. (Tintagel, Cornwall, UK), AMRI (Budapest, Hungary) and ChemDiv (San Diego, Calif.), Specs (Delft, The Netherlands).

Natural compound libraries comprising bacterial, fungal, plant or animal extracts are available from, for example, Pan Laboratories (Bothell, Wash.), TimTec (Newark, Del.). In addition, numerous means are available for random and directed synthesis of a wide variety of organic compounds and biomolecules, including expression of randomized oligonucleotides.

Alternatively, libraries of natural compounds in the form of bacterial, fungal, plant and animal extracts can be readily produced. Methods for the synthesis of molecular libraries are readily available (see, e.g., DeWitt et al., 1993; Erb et al., 1994; Zuckermann et al., 1994; Cho et al., 1993; Carell et al., 1994a; Carell et al., 1994b; and Gallop et al., 1994). In addition, natural or synthetic compound libraries and compounds can be readily modified through conventional chemical, physical and biochemical means (see, e.g., Blondelle and Houghton, 1996), and may be used to produce combinatorial libraries. In another approach, previously identified pharmacological agents can be subjected to directed or random chemical modifications, such as acylation, alkylation, esterification, amidification, and the analogues can be screened for plasmepsin V-modulating activity.

Numerous methods for producing combinatorial libraries are known in the art, including those involving biological libraries; spatially addressable parallel solid phase or solution phase libraries; synthetic library methods requiring deconvolution; the “one-bead one-compound” library method; and synthetic library methods using affinity chromatography selection. The biological library approach is limited to polypeptide or peptide libraries, while the other four approaches are applicable to polypeptide, peptide, non-peptide oligomer, or small molecule libraries of compounds (Lam, 1997).

Compounds also include those that may be synthesized from leads generated by fragment-based drug design, wherein the binding of such chemical fragments is assessed by soaking or co-crystallizing such screen fragments into crystals provided by the invention and then subjecting these to an X-ray beam and obtaining diffraction data. Difference Fourier techniques are readily applied by those skilled in the art to determine the location within plasmepsin V at which these fragments bind, and such fragments can then be assembled by synthetic chemistry into larger compounds with increased affinity for plasmepsin V.

### Isolated Peptides or Mimetics Thereof

Compounds identified or designed using the methods of the invention can be a peptide or a mimetic thereof.

The isolated peptides or mimetics of the invention may be conformationally constrained molecules or alternatively molecules which are not conformationally constrained such as, for example, non-constrained peptide sequences. The term “conformationally constrained molecules” means conformationally constrained peptides and conformationally constrained peptide analogues and derivatives.

The term “analogues” refers to molecules having a chemically analogous structure to naturally occurring a-amino acids. Examples include molecules containing gem-diaminoalkyl groups or alklylmalonyl groups.

The term “derivatives” includes a-amino acids wherein one or more side groups found in the naturally occurring a-amino acids have been modified. Thus, for example the amino acids may be replaced with a variety of uncoded or modified amino acids such as the corresponding D-amino acid or N-methyl amino acid. Other modifications include substitution of hydroxyl, thiol, amino and carboxyl functional groups with chemically similar groups.

With regard to peptides and mimetics thereof, other examples of other unnatural amino acids or chemical amino acid analogues/derivatives which can be introduced as a substitution or addition include, but are not limited to, 2,4-diaminobutyric acid, a-amino isobutyric acid, 4-aminobutyric acid, 2-aminobutyric acid, 6-amino hexanoic acid, 2-amino isobutyric acid, 3-amino propionic acid, ornithine, norleucine, norvaline, hydroxyproline, sarcosine, citrulline, homocitrulline, cysteic acid, t-butylglycine, t-butylalanine, phenylglycine, cyclohexylalanine, β-alanine, fluoro-amino acids, designer amino acids such as β-methyl amino acids, C a-methyl amino acids, N a-methyl amino acids, and amino acid analogues in general.

The mimetic may be a peptidomimetic. A “peptidomimetic” is a molecule that mimics the biological activity of a peptide but is no longer peptidic in chemical nature. By strict definition, a peptidomimetic is a molecule that no longer contains any peptide bonds (i.e., amide bonds between amino acids). However, the term peptide mimetic is sometimes used to describe molecules that are no longer completely peptidic in nature, such as pseudo-peptides, semi-peptides and peptoids. Whether completely or partially non-peptide, peptidomimetics for use in the methods of the invention, and/or of the invention, provide a spatial arrangement of reactive chemical moieties that closely resembles the three-dimensional arrangement of active groups in the peptide on which the peptidomimetic is based. As a result of this similar active-site geometry, the peptidomimetic has effects on biological systems which are similar to the biological activity of the peptide.

There are sometimes advantages for using a mimetic of a given peptide rather than the peptide itself, because peptides commonly exhibit two undesirable properties: (1) poor bioavailability; and (2) short duration of action. Peptide mimetics offer an obvious route around these two major obstacles, since the molecules concerned are small enough to be both orally active and have a long duration of action. There are also considerable cost savings and improved patient compliance associated with peptide mimetics, since they can be administered orally compared with parenteral administration for peptides. Furthermore, peptide mimetics are generally cheaper to produce than peptides.

Suitable peptidomimetics based on WEHI-842 or a fragment thereof can be developed using readily available techniques. Thus, for example, peptide bonds, or in the case of WEHI-842, further peptide bonds can be replaced by non-peptide bonds that allow the peptidomimetic to adopt a similar structure, and therefore biological activity, to the original peptide. Further modifications can also be made by replacing chemical groups of the amino acids with other chemical groups of similar structure. The development of peptidomimetics derived from WEHI-842 or a fragment thereof can be aided by reference to the three dimensional structure of the inhibitor as provided in Appendix I. This structural information can be used to search three-dimensional databases to identify molecules having a similar structure, using programs such as Sybyl/3DB Unity (Tripos Associates, St. Louis, Mo.).

Those skilled in the art will recognize that the design of a peptidomimetic may require slight structural alteration or adjustment of a chemical structure designed or identified using the methods of the invention. In general, chemical compounds identified or designed using the methods of the invention can be synthesized chemically and then tested for ability to modulate and/or inhibit plasmepsin V activity using any of the methods described herein. The methods of the invention are particularly useful because they can be used to greatly decrease the number potential mimetics which must be screened for their ability to modulate and/or inhibit plasmepsin V activity.

The peptides or peptidomimetics of the present invention can be used in assays for screening for candidate compounds which bind to regions of plasmepsin V and potentially interfere with substrate binding within the substrate-binding site to, for example, inhibit or at least reduce cleavage of the PEXEL motif of effector proteins to inhibit or at least reduce the activity of P. falciparum and/or P. vivax plasmepsin V, inhibit or at least reduce protein export and optionally be lethal to P. falciparum and/or P. vivax growth. Peptides or peptidomimetics which mimic target binding sites are particularly useful as specific target molecules for identifying potentially useful ligands for plasmepsin V.

As used herein a “fragment” is a portion of a peptide of the invention which maintains a defined activity of the “full-length” peptide, namely the ability to bind to the substrate-binding site of plasmepsin V and/or interact with the flap of plasmepsin V. Fragments can be any size as long as they maintain the defined activity. Preferably, the fragment maintains at least 50%, more preferably at least 75%, of the activity of the full length polypeptide.

The % identity of a peptide is determined by GAP (Needleman and Wunsch, 1970) analysis (GCG program) with a gap creation penalty=5, and a gap extension penalty=0.3. The query sequence is at least 10 amino acids in length, and the GAP analysis aligns the two sequences over a region of at least 10 amino acids. More preferably, the GAP analysis aligns two sequences over their entire length.

With regard to a defined peptide, it will be appreciated that % identity figures higher than those provided above will encompass preferred embodiments. Thus, where applicable, in light of the minimum % identity figures, it is preferred that the peptide comprises an amino acid sequence which is at least 50%, more preferably at least 55%, more preferably at least 60%, more preferably at least 65%, more preferably at least 70%, more preferably at least 75%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97%, more preferably at least 98%, more preferably at least 99%, more preferably at least 99.1%, more preferably at least 99.2%, more preferably at least 99.3%, more preferably at least 99.4%, more preferably at least 99.5%, more preferably at least 99.6%, more preferably at least 99.7%, more preferably at least 99.8%, and even more preferably at least 99.9% identical to the relevant nominated SEQ ID NO.

Amino acid sequence mutants of the peptides identified or designed using the methods of the invention, and/or of the present invention, can be prepared by introducing appropriate nucleotide changes into a nucleic acid of the present invention, or by in vitro synthesis of the desired peptide. Such mutants include, for example, deletions, insertions or substitutions of residues within the amino acid sequence. A combination of deletion, insertion and substitution can be made to arrive at the final construct, provided that the final peptide product possesses the desired characteristics.

In designing amino acid sequence mutants, the location of the mutation site and the nature of the mutation will depend on characteristic(s) to be modified. The sites for mutation can be modified individually or in series, e.g., by (1) substituting first with conservative amino acid choices and then with more radical selections depending upon the results achieved, (2) deleting the target residue, or (3) inserting other residues adjacent to the located site.

Substitution mutants have at least one amino acid residue in the peptide removed and a different residue inserted in its place. Sites of interest are those in which particular residues obtained from various strains or species are identical. These sites, especially those falling within a sequence of at least three other identically conserved sites, are preferably substituted in a relatively conservative manner. Such conservative substitutions are shown in Table 1 under the heading of “Exemplary Substitutions”.

TABLE 1
Exemplary substitutions.

| Original | Exemplary |
|---|---|
| Residue | Substitutions |
| Ala (A) | Val; Leu; Ile; Gly |
| Arg (R) | Lys |
| Asn (N) | Gln; His |
| Asp (D) | Glu |
| Cys (C) | Ser |
| Gln (Q) | Asn; His |
| Glu (E) | Asp |
| Gly (G) | Pro, Ala |
| His (H) | Asn; Gln |
| Ile (I) | Leu; Val; Ala |
| Leu (L) | Ile; Val; Met; Ala; Phe |
| Lys (K) | Arg |
| Met (M) | Leu; Phe |
| Phe (F) | Leu; Val; Ala |
| Pro (P) | Gly |
| Ser (S) | Thr |
| Thr (T) | Ser |
| Trp (W) | Tyr |
| Tyr (Y) | Trp; Phe |
| Val (V) | Ile; Leu; Met; Phe, Ala |

In a preferred embodiment a mutant/variant peptide has one or two or three or four conservative amino acid changes when compared to a peptide defined herein. Details of conservative amino acid changes are provided above in Table 1.

Also included within the scope of the invention are peptides which are differentially modified during or after synthesis, e.g., by biotinylation, benzylation, glycosylation, acetylation, phosphorylation, amidation, derivatization by known protecting/blocking groups, proteolytic cleavage, linkage to an antibody molecule or other cellular ligand, etc. These modifications may serve to increase the stability and/or bioactivity of the peptide.

With regard to redesigning compounds using a method of the invention, in an embodiment the compound is redesigned to be more structurally similar to the native effector proteins containing the targeted PEXEL motif.

Interaction of Compounds with Plasmepsin V

A compound may interact with the substrate-binding site of plasmepsin V and/or with the flap of plasmepsin V by binding either directly or indirectly to these regions. A compound which binds directly, binds to a specified region. A compound which binds indirectly, binds to a region in close proximity to or adjacent to the substrate-binding site of plasmepsin V and/or to the flap of plasmepsin V with the result that it interferes with the ability of plasmepsin V to bind to native effector proteins containing the targeted PEXEL motif, either antagonistically or agonistically. Such interference may be steric, electrostatic or allosteric. Preferably, a compound interacts with the substrate-binding site of plasmepsin V and/or with the flap of plasmepsin V by binding directly to one or both of the regions. In the case of compounds that bind to specific target molecules, such compounds bind directly to the specific target molecule.

Binding can be either by covalent or non-covalent interactions, or both. Examples of non-covalent interactions include electrostatic interactions, van der Waals interactions, hydrophobic interactions and hydrophilic interactions.

When a compound of the invention interacts with plasmepsin V, it preferably “modulates” plasmepsin V. By “modulate” we mean that the compound changes an activity of plasmepsin V by at least 10%. Suitably, a compound modulates plasmepsin V by reducing or inhibiting plasmepsin V activity. The ability of a candidate compound to reduce or inhibit plasmepsin V activity can be assessed by any one of the plasmepsin V assays described herein.

Compounds of the present invention preferably have an affinity for plasmepsin V sufficient to provide adequate binding for the intended purpose. Suitably, such compounds and compounds which bind to specific target molecules of plasmepsin V have an affinity (KD) of from 10⁻⁵ to 10⁻¹⁵ M. For use as a therapeutic, the compound suitably has an affinity (KD) of from 10⁻⁷ to 10⁻¹⁵ M, preferably from 10⁻⁸ to 10⁻¹² M and more preferably from 10⁻¹⁰ to 10⁻¹² M. Where a compound is to be used as a reagent in a competitive assay to identify other ligands, the compound suitably has an affinity (KD) of from 10⁻⁵ to 10⁻¹² M.

As will be evident to the skilled person, the crystal structure presented herein has enabled, for the first time, direct visualisation of the regions binding WEHI-842 in plasmepsin V.

In one embodiment, a compound may have a high specificity for plasmepsin V and/or a specific target molecule of plasmepsin V but not for other aspartyl proteases, i.e., a compound selectively binds to plasmepsin V. In this respect, a compound suitably has an affinity (KD) for plasmepsin V and/or a specific target molecule of plasmepsin V of no more than 10⁻⁵ M, preferably no more than 10⁻⁷ M, and an affinity for other aspartyl proteases of at least 10⁻⁵ M, preferably at least 10⁻³ M. Such compounds are desirable as, for example, plasmepsin V inhibitors where a propensity to interact with other non-Plasmodium Spp. aspartyl proteases and thus, for example, promote undesirable outcomes, is reduced.

In a preferred embodiment, the plasmepsin V or specific target molecule of plasmepsin V/other aspartyl protease binding affinity ratio for a compound is at least 10, preferably at least 100, more preferably at least 1000.

### Screening Assays and Confirmation of Binding

Compounds of the invention may be subjected to further confirmation of binding to plasmepsin V by co-crystallization of the compound with plasmepsin V and structural determination as described herein.

Compounds designed or selected according to the methods of the present invention are preferably assessed by a number of in vitro and in vivo assays of plasmepsin V function to confirm their ability to interact with and modulate plasmepsin V activity. For example, compounds may be tested for their ability to bind to plasmepsin V and/or for their ability to modulate, e.g., disrupt plasmepsin V activity.

Libraries may be screened in solution by methods generally known in the art for determining whether ligands competitively bind at a common binding site. Such methods may include screening libraries in solution (e.g., Houghten, 1992), or on beads (Lam, 1991), chips (Fodor, 1993), bacteria or spores (U.S. Pat. No. 5,223,409), plasmids (Cull et al., 1992), or on phage (Scott & Smith, 1990; Devlin, 1990; Cwirla et al., 1990; Felici, 1991; U.S. Pat. No. 5,223,409).

Where the screening assay is a binding assay, PEXEL cleavage assays may be used. In such assays, plasmepsin V, potential binding molecules and a labelled PEXEL containing peptide substrate are incubated together, wherein binding efficiency is determined by a detectable signal with signal generated being directly proportional to protease activity. Various labels may be used including radioisotopes, fluorescent molecules, chemiluminescent molecules, enzymes, specific binding molecules, particles, e.g., magnetic particles, and the like.

A variety of other reagents may also be included in the screening assay. These include reagents like salts, neutral proteins, e.g., albumin, detergents, etc., which are used to facilitate optimal binding and/or reduce non-specific or background interactions. Reagents that improve the efficiency of the assay, such as nuclease inhibitors, antimicrobial agents, etc., may be used. The components are added in any order that produces the requisite binding. Incubations are performed at any temperature that facilitates optimal activity, typically between 4 and 40° C.

Direct binding of compounds to plasmepsin V can also be done by Surface Plasmon Resonance (BIAcore) (reviewed in Morton & Myszka, 1998). Here plasmepsin V may be immobilized on a CM5 or other sensor chip by either direct chemical coupling using amine or thiol-disulphide exchange coupling (Nice & Catimel, 1999) or by capturing plasmepsin V as an Fc fusion protein to an appropriately derivatized sensor surface (Morten & Myszka, 1998). The potential binding molecule (called an analyte) is passed over the sensor surface at an appropriate flow rate and a range of concentrations. The classical method of analysis is to collect responses for a wide range of analyte concentrations. A range of concentrations provides sufficient information about the reaction, and by using a fitting algorithm such as CLAMP (see Morton & Myszka, 1998), rate constants can be determined (Morton & Myszka, 1998; Nice & Catimel, 1999). Normally, the ligand surface is regenerated at the end of each analyte binding cycle. Surface regeneration ensures that the same number of ligand binding sites is accessible to the analyte at the beginning of each cycle.

Incubation periods are selected for optimum activity, but may also be optimized to facilitate rapid high-throughput screening. Normally, between 0.05 and 1 hour will be sufficient. In general, a plurality of assay mixtures is run in parallel with different test agent concentrations to obtain a differential response to these concentrations. Typically, one of these concentrations serves as a negative control, i.e. at zero concentration or below the level of detection.

To measure the efficiency of compounds in vivo in inhibiting plasmepsin V activity, pulse chase analysis may be used. In such analysis, the pulse may include P. falciparum and/or P. vivax-infected erythrocytes being cultured in medium containing potential binding molecules, labelled-substrate and a radiolabel. The chase may include chasing the export of labelled proteins to the erythrocyte by culturing the infected erythrocytes in label-free and inhibitor-free medium for various incubation periods before quantifying the amount of labelled protein exported by densitometry analysis.

### Uses of Compounds

Compounds/chemical entities designed or selected by the methods of the invention described above may be used to modulate plasmepsin V activity in cells, i.e., inhibit or at least reduce plasmepsin V activity. Such compounds may interact with the substrate-binding site and/or the flap of plasmepsin V as defined herein.

Given that P. falciparum and P. vivax infections are causative of malaria, the compounds described above may be used to treat, ameliorate or prevent malaria by modulating plasmepsin V activity, preferably inhibit plasmepsin V activity.

Compounds provided by this invention may also be useful as assay reagents for identifying other useful ligands by, for example, competition assays, as research tools for further analysis of plasmepsin V and as potential therapeutics in pharmaceutical compositions.

Compounds provided by this invention may also useful as lead compounds for identifying other more potent or selective compounds.

In one embodiment, one or more of the compounds may be provided as components in a kit for identifying other ligands (e.g., small, organic molecules) that bind to plasmepsin V. Such kits may also include plasmepsin V, or functional fragments thereof. The compound and plasmepsin V or components thereof of the kit may be labelled (e.g., by radioisotopes, fluorescent molecules, chemiluminescent molecules, enzymes or other labels), or may be unlabelled and labelling reagents may be provided. The kits may also contain peripheral reagents such as buffers, stabilizers, etc. Instructions for use may also be provided.

### Administration

Compounds of the invention may preferably be combined with various components to produce compositions of the invention. Preferably the compositions are combined with a pharmaceutically acceptable carrier or diluent to produce a pharmaceutical composition (which may be for human or animal use).

The formulation will depend upon the nature of the compound and the route of administration but typically they can be formulated for topical, parenteral, intramuscular, oral, intravenous, intra-peritoneal, intranasal inhalation, lung inhalation, intradermal or intra-articular administration. The compound may be used in an injectable form. It may therefore be mixed with any vehicle which is pharmaceutically acceptable for an injectable formulation, preferably for a direct injection at the site to be treated, although it may be administered systemically.

The pharmaceutically acceptable carrier or diluent may be, for example, sterile isotonic saline solutions, or other isotonic solutions such as phosphate-buffered saline. The compounds of the present invention may be admixed with any suitable binder(s), lubricant(s), suspending agent(s), coating agent(s), solubilising agent(s). It is also preferred to formulate the compound in an orally active form. Pharmaceutically acceptable carriers, diluents and excipients which can be used in the pharmaceutical compositions of the invention will be known to those of skill in the art. The British Pharmacopoeia (BP) and the United States Pharmacopeia and National Formulary (USP-NF) contain details of suitable carriers, diluents and excipients, as does Sweetman S (Ed.), ‘Martindale: The complete drug reference.’ London: Pharmaceutical Press, 37th Ed., (2011), and Rowe R C, Sheskey P J, Quinn M E (Ed.), ‘Handbook of Pharmaceutical Excipients’, 6th Ed., London: Pharmaceutical Press (2009), the contents of which are incorporated herein by cross reference.

In general, a therapeutically effective daily oral or intravenous dose of the compounds of the invention, including compounds of the invention and their salts, is likely to range from 0.01 to 50 mg/kg body weight of the subject to be treated, preferably 0.1 to 20 mg/kg. The compounds of the invention and their salts may also be administered by intravenous infusion, at a dose which is likely to range from 0.001-10 mg/kg/hr.

Tablets or capsules of the compounds may be administered singly or two or more at a time, as appropriate. It is also possible to administer the compounds in sustained release formulations.

Typically, the physician will determine the actual dosage which will be most suitable for an individual patient and it will vary with the age, weight and response of the particular patient. The above dosages are exemplary of the average case. There can, of course, be individual instances where higher or lower dosage ranges are merited, and such are within the scope of this invention.

For some applications, preferably the compositions are administered orally in the form of tablets containing excipients such as starch or lactose, or in capsules or ovules either alone or in admixture with excipients, or in the form of elixirs, solutions or suspensions containing flavouring or colouring agents.

The compositions (as well as the compounds alone) can also be injected parenterally, for example intravenously, intramuscularly or subcutaneously. In this case, the compositions will comprise a suitable carrier or diluent.

For parenteral administration, the compositions are best used in the form of a sterile aqueous solution which may contain other substances, for example enough salts or monosaccharides to make the solution isotonic with blood.

For buccal or sublingual administration the compositions may be administered in the form of tablets or lozenges which can be formulated in a conventional manner.

For oral, parenteral, buccal and sublingual administration to subjects (such as patients), the daily dosage level of the compounds of the present invention and their pharmaceutically acceptable salts and solvates may typically be from 10 to 500 mg (in single or divided doses). Thus, and by way of example, tablets or capsules may contain from 5 to 100 mg of active compound for administration singly, or two or more at a time, as appropriate. As indicated above, the physician will determine the actual dosage which will be most suitable for an individual patient and it will vary with the age, weight and response of the particular patient.

The routes of administration and dosages described are intended only as a guide since a skilled practitioner will be able to determine readily the optimum route of administration and dosage for any particular patient depending on, for example, the age, weight and condition of the patient.

### EXAMPLES

### Experimental Procedures

### Protein Expression and Purification

P. vivax plasmepsin V (residues R35-R476 according to SEQ ID NO:2), bearing an N-terminal gp67 signal peptide, and a fusion tag comprised of a FLAG tag, SUMO domain and tobacco etch virus (TEV) protease cleavage site was expressed in High Five insect cells (SEQ ID NO: 5).

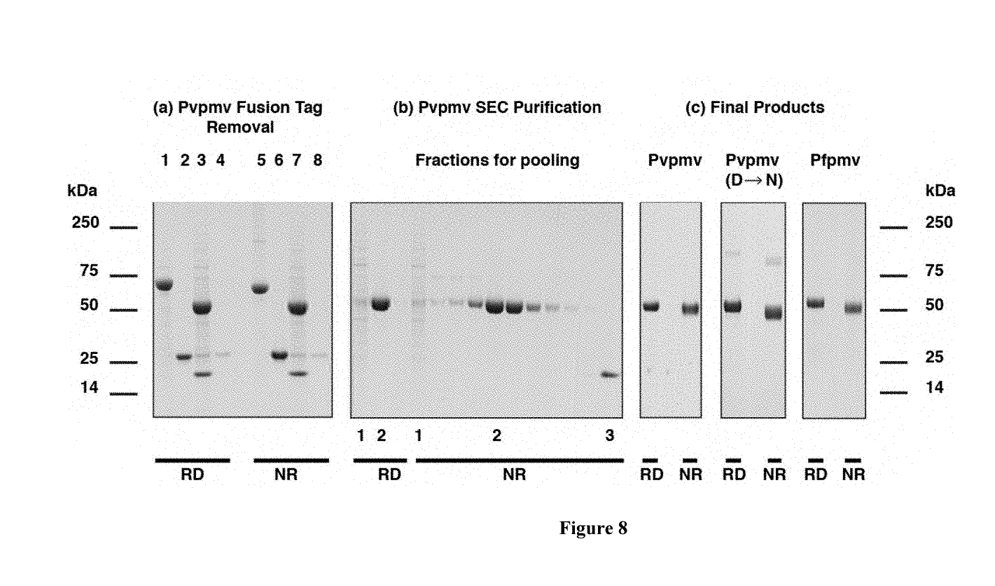

Recombinant protein was affinity purified initially from cell supernatant using anti-FLAG M2-agarose (Sigma). Pooled fractions were concentrated and the N-terminal fusion tag removed using TEV protease (1:25 v/v, 5 hr, room temperature; see FIG. 8; SEQ ID NO: 6).

Size exclusion chromatography (SEC) was then used to obtain high purity plasmepsin V. SEC (Superdex 75, GE lifesciences) was carried out in 20 mM HEPES pH7.2/100 mM NaCl/0.2 mM DTT and resulted in pure and stable protein that was concentrated for crystallisation (see again FIG. 8).

A similar procedure was used for the production of P. falciparum plasmepsin V (residues N80-R528 according to SEQ ID NO:1) except that sf21 insect cells were used for protein expression as less covalent aggregate was produced in this cell system.

### Kinetic Characterisation of Recombinant Plasmepsin V

The in vitro activity of recombinant P. falciparum and P. vivax plasmepsin V was assessed against a fluorogenic peptide of nine amino acids that contained the PEXEL sequence from knob-associated histidine-rich protein (“KAHRP”) (DABCYL-RNKRTLAQKQ-E-EDANS; SEQ ID NO: 7).

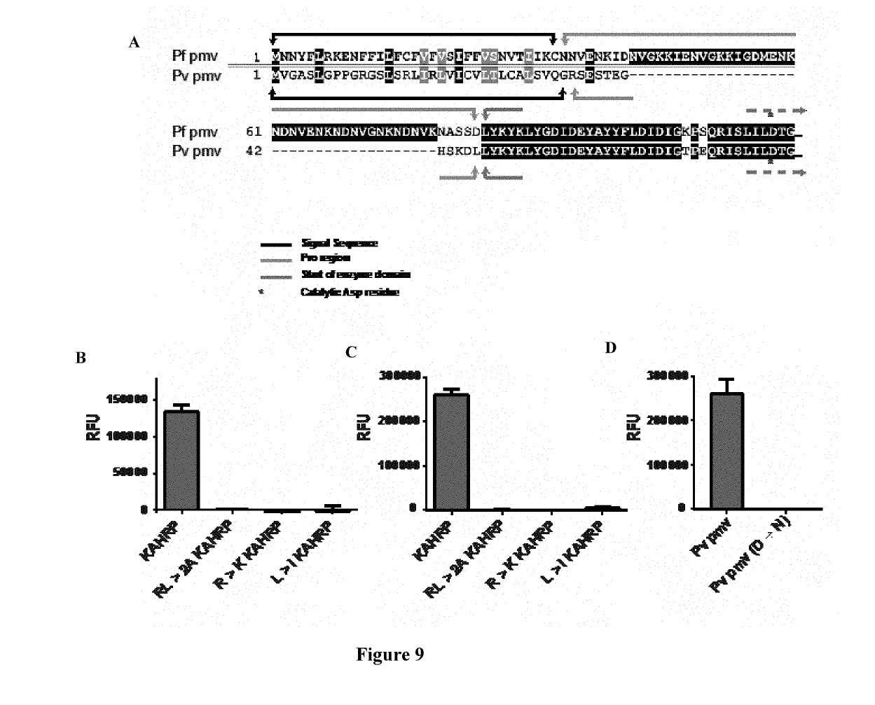

Both plasmepsin V demonstrated specific activity against the PEXEL substrates and cleaved the peptides after the P1 Leucine residue as expected (see FIG. 9).

Values for Kₘ were derived from both the inverse Michaelis-Menten and the Lineweaver-Burk plots. These values were of the same magnitude for each enzyme and are also similar to the Kₘ derived from the activity of another recombinant form of P. falciparum plasmepsin V on a different PEXEL substrate (Xiao, H. et al. 2014).

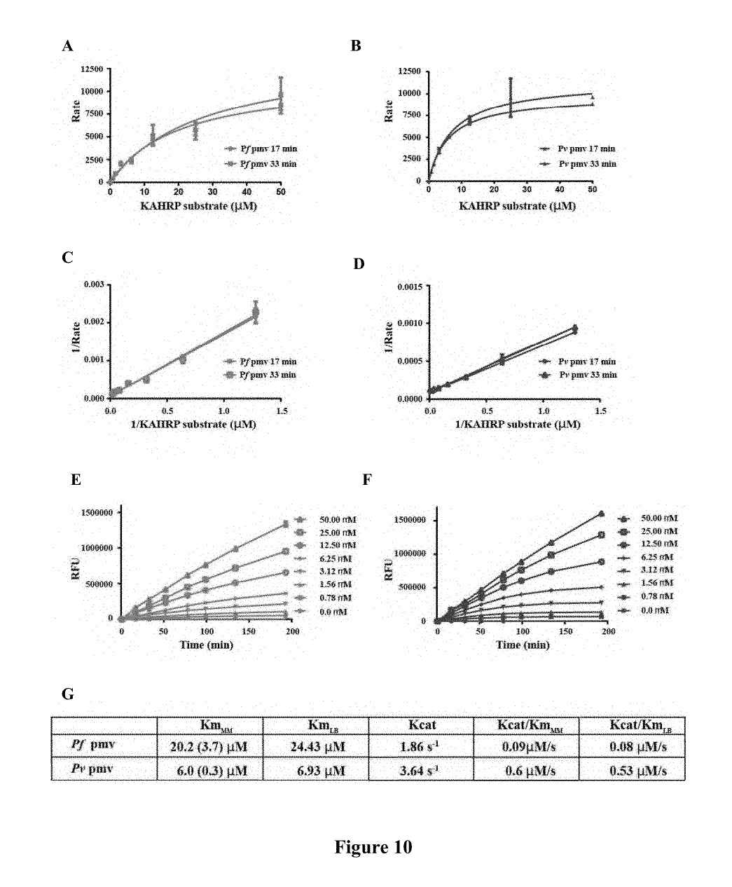

The Kₘ for recombinant plasmepsin V using the fluorogenic PEXEL substrate from KAHRP (SEQ ID NO:7) was 20.2 μM and 6.0 μM for the P. falciparum and P. vivax enzymes, respectively (see FIGS. 9 and 10).

PEXEL cleavage assays (20 μl total volume) consisted of 1 ng/well of P. vivax plasmepsin V or 1.5 ng/well of P. falciparum plasmepsin V in buffer (25 mM Tris.HCl, 25 mM MES, pH 6.4) with 5 μM FRET peptide substrate (DABCYL-RNKRTLAQKQ-E-EDANS (SEQ ID NO:7) or peptides with the sequence DABCYL-RNKKTLAQKQ-E-EDANS (SEQ ID NO:8) or DABCYL-RNKRTIAQKQ-E-EDANS (SEQ ID NO:9)) (Sleebs, B. E. et al. 2014a; see FIG. 9). Samples were incubated at 37° C. for 120 min and measured using an Envision plate (Perkin-Elmer) reader (Ex 340 nm/Em 490 nm).

### Compound Evaluation

Compounds WEHI-916 (see FIG. 1A) and WEHI-842 were evaluated using the fluorogenic PEXEL cleavage assays described above (Sleebs, B. E. et al. 2014a).

Reactions comprised of a fluorescent peptide of nine amino acids containing the PEXEL sequence (RTLAQ) from KAHRP. The KAHRP PEXEL peptide substrate DABCYL-RNKRTLAQKQ-E-EDANS (SEQ ID NO:7) was obtained commercially and used at a final assay concentration of 7.5 μM.

The end-point for all assays was set within the linear range of activity (approximately 1 hr.).

Tween-20 was used at 0.005% final assay concentration. Final assay buffer concentration was as follows: 25 mM Tris HCl, 25 mM MES (pH 6.4). Final assay volume was 20 μL.

An 11-point 1/3 serial dilution of compounds was generated using DMSO as a diluent (final assay concentration of 1%).

Assay reaction was incubated for 60 min at 37° C. and read using a fluorescence plate reader (Ex 340 nm, Em 495 nm). IC₅₀ values were determined using a nonlinear regression four-parameter fit analysis, where two of the parameters were constrained to 0 and 100%.

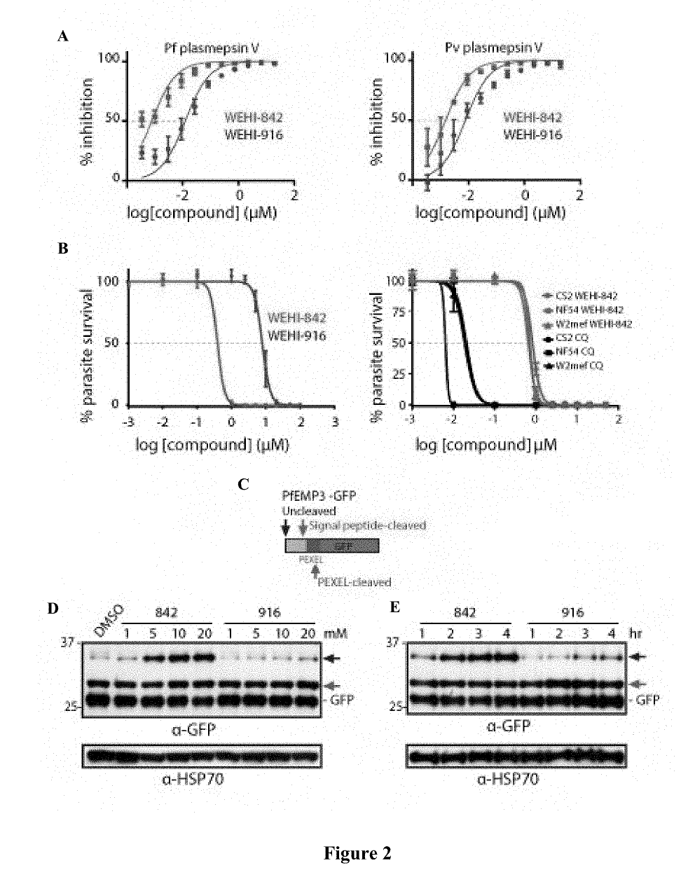

WEHI-842 was shown to have a 15-fold increased potency against recombinant P. falciparum plasmepsin V (IC₅₀ of 0.79 nM) compared to WEHI-916 (IC₅₀ of 12.9 nM) (see FIG. 2A). A similar difference in potency was observed between WEHI-842 and WEHI-916 in their ability to inhibit P. vivax plasmepsin V with IC₅₀ values of 1.6 nM and 8.2 nM, respectively (see FIG. 2A).

### Parasites and Growth Assays

P. falciparum strains 3D7, NF54, CS2 and W2mef were cultured in human O+ erythrocytes at 4% haematocrit in RPMI 1640 medium containing 25 mM HEPES, pH 7.4, 0.2% sodium bicarbonate, 0.5% Albumax II (Life Technologies) and 5 nM WR99210 selection where required (a gift from Jacobus Pharmaceuticals) in 5% CO₂, 5% O₂, 90% N at 37° C.

P. falciparum 3D7 expressing the PEXEL protein erythrocyte membrane protein 3 (PfEMP3) fused to green fluorescent protein (GFP) (PfEMP3-GFP) was generated previously (Boddey, J. A. et al, 2010) (see FIG. 2C).

Growth assays were performed in 96 well plates by incubating ring-stage P. falciparum parasites with WEHI-916 or WEHI-842 solubilized in DMSO, or chloroquine solubilised in water, at the indicated concentrations and parasitaemia was determined at 72 hr by flow cytometry as described previously (Sleebs, B. E. et al. 2014a).

P. falciparum trophozoites expressing PfEMP3-GFP were magnet-purified (Miltenyi Biotech), incubated with inhibitors for 1-4 hr. at 37° C., treated with 0.09% saponin containing inhibitor, and washed pellets were solubilized in Laemmli's buffer, boiled for 3 min and proteins were separated by SDS-PAGE, transferred to nitrocellulose and blocked in 1% skim milk. Membranes were probed with mouse a-GFP (Roche; 1:1000), rabbit a-Aldolase (1:1000) or rabbit a-HSP70 (1:4000) antibodies followed by horseradish peroxidase-conjugated secondary antibodies (Silenius; 1:2000) and visualized using enhanced chemiluminescence (Amersham). To radiolabel P. falciparum proteins, magnet-purified trophozoites expressing PfEMP3-GFP were treated with 10 μM inhibitors for 3 hr. (the final 30 min in Met/Cys-free medium) at 37° C. before addition of 800 μCi/ml 35S-Met/Cys (Perkin/Elmer) to the medium for 10 min. PfEMP3-GFP protein species were then immunoprecipitated from parasite lysates solubilized in 1% Triton X-100/PBS containing 1× complete protease inhibitors (Roche) using anti-GFP agarose (MBL) for 2 hours at 4° C. and proteins were resolved by SDS-PAGE, visualized by autoradiography and quantified using a GS-800 Calibrated Densitometer (Bio-Rad) (Sleebs, B. E. et al. 2014a).

The ability of WEHI-842 to inhibit growth of P. falciparum (3D7) parasites, a chloroquinesensitive strain, was found to be 10 fold better than parasites treated the same way with WEHI-916 (EC₅₀ 0.40 μM and EC₅₀ 5.0 μM, respectively) (see FIG. 2B). The effect of WEHI-842 on other P. falciparum parasites, including alternative chloroquine-resistant strains, was similar to 3D7 (EC50 0.47 μM, 0.64 μM and 0.83 μM for NF54, W2mef and CS2, respectively). Hence, WEHI-842 is a potent inhibitor of plasmepsin V protease activity in vitro and capable of blocking growth of blood stage P. falciparum.

The growth assays also showed that WEHI-842 efficiently inhibited PEXEL cleavage, as shown by accumulation of a 35 kDa band corresponding to full-length PfEMP3-GFP (Boddey, J. A. et al. 2010; Sleebs, B. E. et al. 2014a) (see FIGS. 2C and D). The degree of PEXEL processing inhibition by WEHI-842 compared to WEHI-916 was 10-fold greater and the time required to inhibit plasmepsin V was significantly less for WEHI-842 than WEHI-916, requiring 3 hours for optimal inhibition (see FIG. 2D) compared to 5 hours for WEHI-916 (Sleebs, B. E. et al. 2014). Additionally, WEHI-842 was found to be more potent at inhibiting plasmepsin V than WEHI-916, when tested at the same concentrations on parasites expressing PfEMP3-GFP (see FIG. 2D).

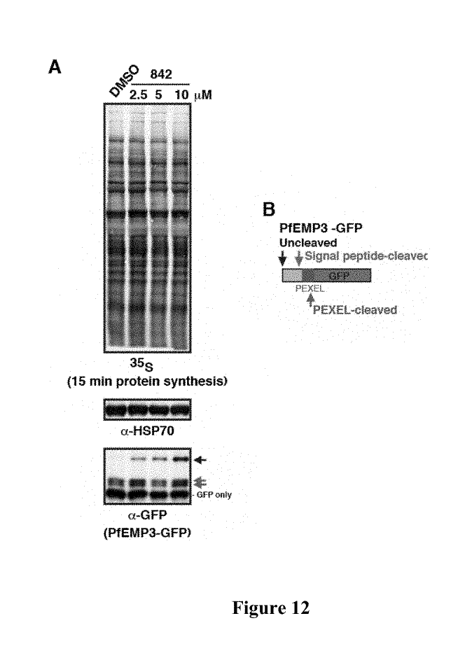

In order to provide evidence WEHI-842 specifically inhibited plasmepsin V and no other normal cellular functions, magnet purified trophozoites treated with DMSO or WEHI-842 (2.5, 5, 10 μM) for 3 hr prior to labelling parasite proteins with 35S-methionine/cysteine for 15 min (see FIG. 12). The effect on PfEMP3-GFP processing was also examined by immunoblot.

Treatment with 10 jμM WEHI-842 for 3 hours showed no inhibitory effect on translation but potently inhibited plasmepsin V cleavage of PfEMP3-GFP. These results show that WEHI-842 is a potent and specific inhibitor of plasmepsin V cleavage of the PEXEL in P. falciparum parasites.

### Pulse Chases to Measure Protein Export and Inhibition

Pulse chases were performed by radiolabelling proteins as above, before further culture in radiolabel-free, inhibitor-free complete medium for 30 and 60 min at 37° C. before PfEMP3-GFP protein species were purified, resolved, visualized and quantified by densitometry, as described above.

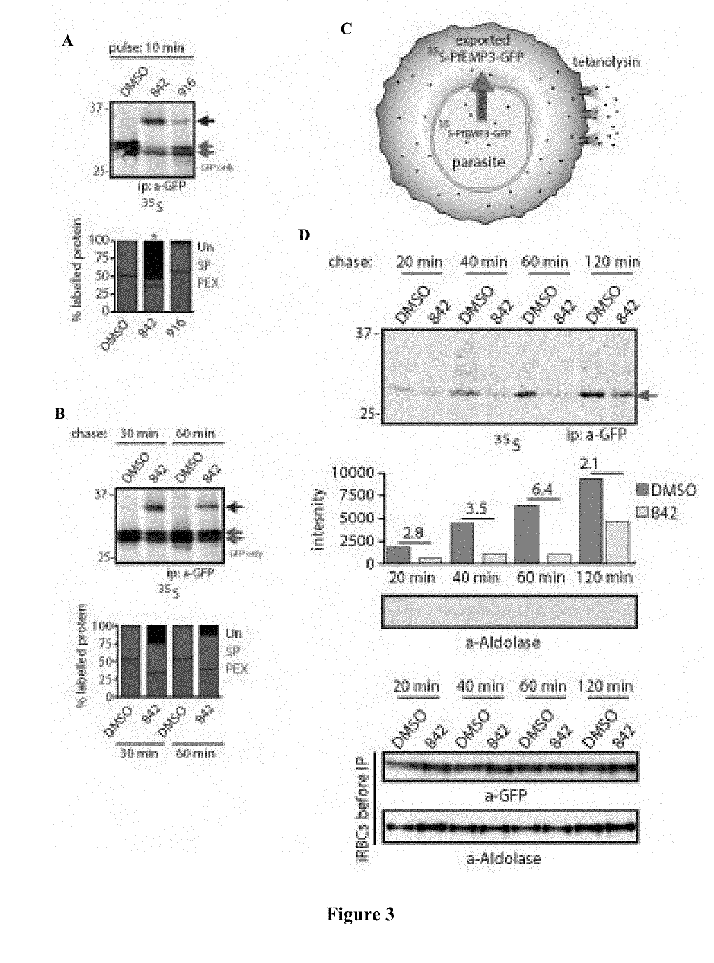

Pulse: P. falciparum trophozoites expressing PfEMP3-GFP were magnet-purified (Miltenyi Biotech) and treated with 10 μM WEHI-842 or DMSO for 3 hr. Parasite proteins were labelled in the presence of inhibitors by addition of 800 μCi/ml 35S-Met/Cys (Perkin/Elmer) to the medium for the last 50 min of the 3 hr. inhibitor treatment time (this included 30 min in Met/Cys-free medium containing inhibitor prior to labeling). Chase: Export of labeled proteins to the erythrocyte was chased by culturing parasites in radiolabel-free, inhibitor-free complete medium for either 20, 40, 60 or 120 min at 37° C. before exported proteins were liberated from the infected erythrocytes by tetanolysin treatment (100 U/mL tetanolysin (Sigma), 0.2% bovine serum albumin (Sigma), 1× complete protease inhibitor cocktail (Roche)) for 5 min at 37° C. and centrifugation at 1500 g for 1 min. PfEMP3-GFP proteins were purified from the tetanolysin supernatant fraction and resolved, visualized and quantified by densitometry, as described above (see FIGS. 3A and 3B).

WEHI-842 was found to be 10-fold more potent than WEHI-916 at inhibiting plasmepsin V cleavage of the PEXEL motif in PfEMP3-GFP. Removal of WEHI-842 and continued growth in inhibitor-free medium showed inhibition of PEXEL cleavage was reversible, as the parasite recommenced cleaving full-length PfEMP3-GFP (see FIG. 3B). The inhibition of PfEMP3-GFP processing also blocked export of this protein to parasite-infected erythrocytes, as determined using tetanolysin (see FIG. 3C). While export in the presence of DMSO could be detected after 20 min and steadily increased after 40, 60 and 120 min, WEHI-842 pre-treatment dramatically reduced export at 20, 40 and 60 min (see FIG. 3D). Efficient export of PfEMP3-GFP returned after 120 min demonstrating PEXEL-cleavage inhibition was reversible (see FIG. 3B) and this caused a similar reversal of export inhibition (see FIG. 3D). Therefore WEHI-842 efficiently blocks export of proteins to P. falciparum-infected erythrocytes by inhibition of plasmepsin V cleavage of the PEXEL.

### Surface Plasmon Resonance

Surface plasmon resonance was performed using a Biacore 4000 (GE Healthcare). Plasmepsin V was immobilized on a Series S CM5 sensor chip using amine-coupling chemistry. The surfaces of flow cells were activated for 10 min with a 1:1 mixture of 0.1 M NHS (N-hydroxysuccinimide) and 0.1 M EDC (3-(N,N-dimethylamino)propyl-N-ethylcarbodiimide) at a flow rate of 5 al/min. Plasmepsin V (20 μg/ml in 10 mM sodium acetate, pH 4.5, was immobilized at a density of approximately 10,000. Spot 3 was activated and deactivated as above and used as a reference surface. All surfaces were blocked with a 7 min injection of 1 M ethanolamine, pH 8.0. WEHI-916 and WEHI-842 11-point titrations were prepared by diluting 1:2 from 1000 nM and injected at a flow rate of 30 μl/min. Buffer used was 10 mM HEPES, 150 mM NaCl, 3 mM EDTA, 0.05% Tween and 2% DMSO. Analysis was performed at 25° C. After compound injection, the chip surface was regenerated with 10 mM glycine-HCl, pH 2 for 30 s. Compounds were allowed to associate and dissociate for 250 s and 600 s, respectively. Data were collected at a rate of 10 Hz and fit to a 1:1 interaction model using the Biacore 4000 Evaluation Software Version 1.0.

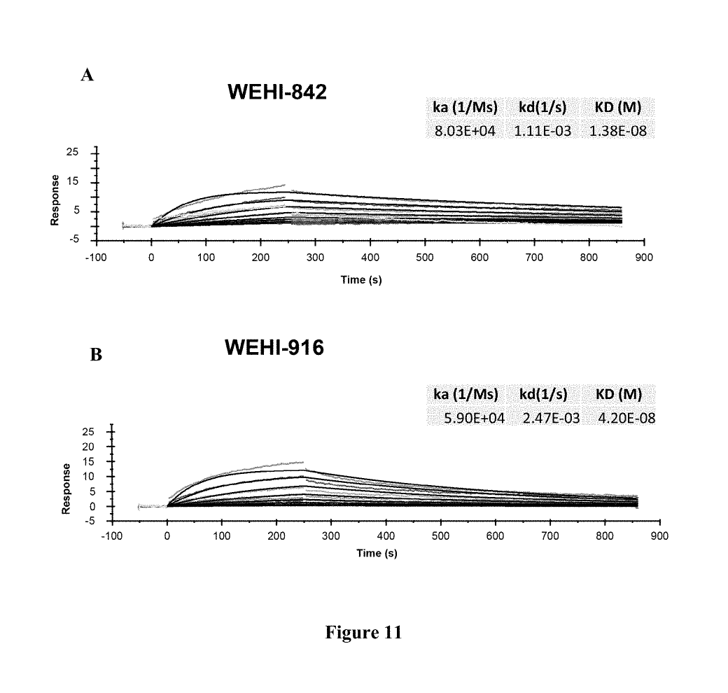

The surface plasmon experiments showed that the affinity (KD) of WEHI-842 and WEHI-916 for P. vivax plasmepsin V were 13.4 and 42.0 nM, respectively (see FIG. 11). As shown, WEHI-842 has more than a two-fold higher affinity for P. vivax plasmepsin V than WEHI-916.

Furthermore, the k_{d} for WEHI-842 was found to be lower than that for WEHI-916 (k_{d} of 1.11 E-03 (1/s) and 2.47 E-03 (1/s) respectively), this slower off-rate is consistent with the higher affinity of WEHI-842. Taken together these results show that WEHI-842 is a considerably more potent inhibitor for of P. falciparum and P. vivax plasmepsin V than WEHI-916.

Crystallisation, Structure Solution and Refinement of Plasmepsin V in Complex with WEHI-842

### Crystallization

Samples of P. vivax plasmepsin V (8 mg/ml) were prepared for crystallisation by combining with a 6× molar ratio of WEHI-842.

A crystallization condition (0.11M ammonium sulfate/5% (v/v) jeffamine M-600/15.5% (w/v) polyethylene glycol 4000/0.1M sodium acetate-acetic acid pH4.16) was detected and refined for P. vivax plasmepsin V/WEHI-842.

### Diffraction Data Collection

Single crystals of the P. vivax plasmepsin V/WEHI-842 were frozen in well solution supplemented with 20% Ethylene Glycol.

All diffraction data was processed using the XDS suite (Kabsch, W., 2010; Evans, P. R., 2011), Pointless (Evans, P. R., 2011) and Aimless (Evans, P. R. & Murshudov, G. N., 2013). Statistics for the dataset is provided in Table 2 below.

### Structure Solution and Refinement

The structure was solved by molecular replacement with Phaser (McCoy, A. J. et al., 2007) using a Sculptor (Bunkoczi, G. & Read, R. J., 2011) modified version of Cathepsin E (PDB 1TZS; Ostermann, N. et al., 2004) as the search model.

Further rounds of building and refinement with Coot (Emsley, P. & Cowtan, K., 2004) and Phenix (Adams, P. D., et al. 2010) yielded the final model. Patches of poorly defined density connected residues R241-E272 as per SEQ ID NO:2 but was of inadequate quality for confident model building. Density observed proximal to Asn355 may be due to glycosylation of this residue during protein expression. Refinement statistics are also provided in Table 2 below.

TABLE 2
X-ray Data Collection and Refinement Statistics

PmV

Data collection

| Space group | C 1 2 1 | |
|---|---|---|
| Cell dimensions | | |
| a, b, c (Å) | 91.99, 203.09, 82.16 | |
| a, b, g (°) | 90, 121.07, 90 | |
| Resolution (Å) | 41.85-2.368 | (2.453-2.368)¹ |
| R_{merge}² | 0.1158 | (0.6263) |
| I/σI | 8.96 | (2.07) |
| Completeness (%) | 99.22 | (98.65) |
| Redundancy | 3.8 | (3.7) |
| Refinement | | |
| Resolution (Å) | 41.85-2.368 | (2.427-2.368) |
| No. reflections | 51858 | (3650) |

| | |
|---|---|
| R_{work}/R_{free}³ | 0.1794 (0.2525)/0.2237 (0.3326) |
| No. atoms | 6854 |
| Protein | 6402 |
| Ligand/ion | 168 |
| Water | 284 |
| B-factors | 40.20 |
| Protein | 39.90 |
| Ligand/ion | 52.50 |
| Water | 40.20 |
| R.m.s. deviations | |
| Bond lengths (Å) | 0.009 |
| Bond angles (°) | 1.16 |

¹Numbers in parentheses refer to the statistic in the highest resolution shell.
²R_{merge} = hkl i | Iᵢ(hkl) − <I(hkl)> |/hkl i Iᵢ(hkl)
³R_{work} and R_{free} are computed using R = <|Fₕ^{xpct} − Fₕ^{obs}|>/<| Fₕ^{obs} |> (where Fₕ^{xpct} is the expectation value of the model structure amplitude; Blanc et al., 2004).

### General Chemistry Methods

Analytical thin-layer chromatography was performed on Merck silica gel 60F254 aluminum-backed plates and were visualized by fluorescence quenching under UV light or by KMnO₄ staining. Flash chromatography was performed with silica gel 60 (particle size 0.040-0.063 mm). NMR spectra were recorded on a Bruker Avance DRX 300 (1H NMR at 300 MHz) or a Varian 600 (1H NMR at 600 MHz) with the solvents indicated. Chemical shifts are reported in ppm on the δ scale and referenced to the appropriate solvent peak. MeOD contains H₂O. HRESMS were acquired by Jason Dang at the Monash Institute of Pharmaceutical Sciences Spectrometry Facility using an Agilent 1290 infinity 6224 TOF LCMS. Column used was RRHT 2.1×50 mm 1.8 μm C18. Gradient was applied over the 5 min with the flow rate of 0.5 mL/min. For MS: Gas temperature was 325° C.; drying gas 11 L/min; nebulizer 45 psig and the fragmentor 125V. LCMS were recorded on a Waters ZQ 3100 using a 2996 Diode Array Detector. LCMS conditions used to assess purity of compounds were as follows, column: XBridge™ C18 5 μm 4.6×100 mm, injection volume 10 μL, gradient: 10-100% B over 10 min (solvent A: water 0.1% formic acid; solvent B: AcCN 0.1% formic acid), flow rate: 1.5 mL/min, detection: 100-600 nm. All final compounds were analyzed using ultrahigh performance liquid chromatography/ultraviolet/evaporative light scattering detection coupled to mass spectrometry. Unless otherwise noted, all compounds were found to be >95% pure by this method. WEHI-916 was prepared as previously described (Sleebs, B. E. et al, 2014a; Sleebs, B. E. et al., 2014b).

### Synthesis of WEHI-842

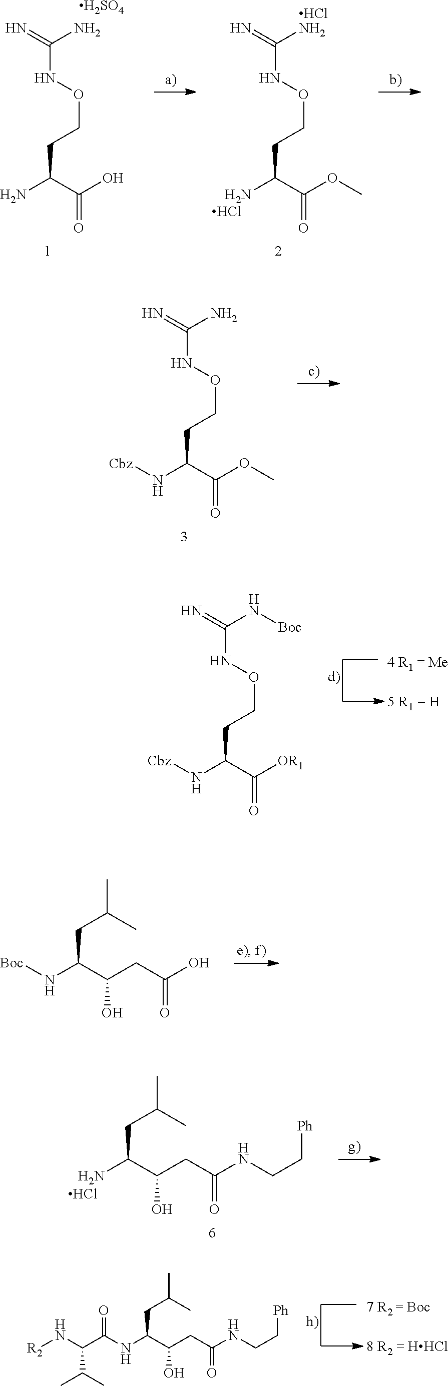

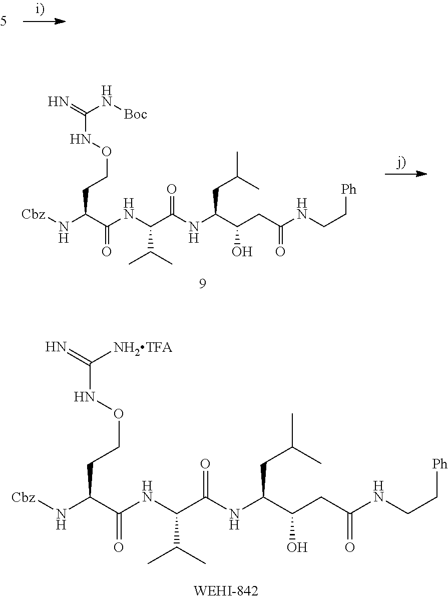

### Reagents and Conditions

a) SOCl₂, MeOH, 18 h; b) Cbz-OSu, Et₃N, THF, H₂O, 1 h; c) (Boc)₂O, Et₃N, THF, H₂O, 18 h; d) LiOH, THF, H₂O, 4 h; e) phenylethylamine, HBTU, DIPEA, DMF, 18 h; f) 4N HCl in dioxane, 1 h; g) Boc-Val-OH, HBTU, DIPEA, DMF, 18 h; h) 4N HCl in dioxane, 1 h; i) HCl.NH₂—Val-Sta-NH(CH₂)₂Ph 8, HBTU, DIPEA, DMF, 18 h; j) TFA, DCM, 18 h.

### Compound 2 2HCl.NH₂—Cav-OMe (2)

Thionyl chloride (529 μL, 7.29 mmol) was added drop-wise to MeOH (8 mL) at 0° C. under a nitrogen atmosphere. H₂SO₄.H-Cav-OH 1 (1 g, 3.65 mmol) was added and the resulting suspension was allowed to stir for 18 h at 20° C. The reaction mixture was concentrated to dryness in vacuo to obtain 2 as a colourless hygroscopic residue (920 mg, 99%). 1H NMR (600 MHz, DMSO) δ 8.63 (br s, 2H), 7.76 (s, 4H), 4.17 (t, J=6.7 Hz, 1H), 4.02-3.92 (m, 2H), 3.76 (s, 3H), 2.24-2.06 (m, 2H).

### Compound 3 Cbz-Cav-OMe (3)

A mixture of 2HCl.NH₂—Cav-OMe 2 (330 mg, 1.25 mmol), Et₃N (262 μL, 1.88 mmol), and Cbz-OSu (281 mg, 1.13 mmol) in a mixture of water (4 mL) and THF (5.3 mL) was allowed to stir for 1 h at 20° C. The reaction was quenched with saturated NaHCO₃ and extracted with EtOAc (3×20 mL). The combined organic layers were washed with brine (30 mL) and dried with MgSO₄. The solvent was concentrated in vacuo to obtain a crude residue. The crude residue was subjected to silica chromatography gradient eluting with 100% DCM to 20% MeOH/DCM to obtain 3 as a colourless hygroscopic residue (270 mg, 57%). 1H NMR (600 MHz, MeOD) δ 7.39-7.24 (m, 5H), 5.17-5.03 (m, 2H), 4.43-4.10 (m, 1H), 3.95-3.78 (m, 2H), 3.77-3.59 (m, 3H), 2.28-1.86 (m, 2H). 13C NMR (75 MHz, MeOD) δ 174.69, 159.16, 158.67, 138.08, 129.47, 129.02, 128.76, 70.27, 67.72, 67.49, 52.76, 31.65. MS, m/z=325.1 [M+H]+.

### Compound 4 Cbz-Cav(N,N-Boc)-OMe (4)

A mixture of Cbz-Cav-OMe 3 (270 mg, 0.832 mmol), Et3N (147 μL, 1.25 mmol), and Boc-anhydride (218 mg, 0.999 mmol) in a mixture of water (3 mL) and THF (12 mL) was allowed to stir for 18 h at 20° C. Water was added to the reaction mixture and extracted with EtOAc (3×10 mL). The combined organic layers were dried over MgSO4 and the solvent was concentrated in vacuo to obtain a crude residue. The crude residue was subjected to silica chromatography gradient eluting with 100% cyclohexane to 80% EtOAc/cyclohexane to obtain 4 as a colourless hygroscopic residue (122 mg, 35%). 1H NMR (600 MHz, CDCl3) δ 7.38-7.24 (m, 5H), 6.10 (br s, 1H), 5.77 (d, J=8.2 Hz, 1H), 5.08 (s, 2H), 4.55-4.44 (m, 1H), 3.93-3.83 (m, 2H), 3.76-3.60 (m, 3H), 2.24-1.97 (m, 2H), 1.45 (d, J=12.5 Hz, 9H). 13C NMR (151 MHz, CDCl3) δ 173.29, 156.06, 153.27, 151.25, 136.31, 128.54, 128.17, 128.07, 82.04, 68.81, 67.01, 52.51, 51.58, 31.38, 28.17. MS, m/z=425.3 [M+H]+.

### Compound 5 Cbz-Cav(N,N-Boc)-OH (5)

A mixture of Cbz-Cav(N,N-Boc)-OMe 4 (100 mg, 0.236 mmol), and LiOH hydrate (35 mg, 0.825 mmol) in a mixture of water (1 mL) and THF (3 mL) was allowed to stir for 4 h at 20° C. 10% Citric acid solution was added to the reaction mixture. The solution was extracted with EtOAc (3×10 mL). The combined organic layers were washed with brine (20 mL) and dried with MgSO₄. The solvent was concentrated in vacuo to obtain 5 as an oil (96 mg, 99%). 1H NMR (600 MHz, MeOD) δ 7.39-7.23 (m, 5H), 5.14-5.09 (m, 2H), 4.40-4.29 (m, 1H), 4.00 (br s, 2H), 2.35-2.23 (m, 1H), 2.03-1.94 (m, 1H), 1.51 (s, 9H). MS, m/z=411.3 [M+H]+.

Compound 6 HCl.NH₂—Sta-NH(CH₂)₂Ph (6)

Compound 6 was synthesized according to previously described procedure (Sleebs, B. E. et al, 2014a; Sleebs, B. E. et al., 2014b).

Compound 7 Boc-Val-Sta-NH(CH₂)₂Ph (7)

To a stirred solution of Boc-Val-OH (90 mg, 0.414 mmol) in DMF (1.8 mL) was added HBTU (204 mg, 0.538 mmol) and DIPEA (361 μL, 2.07 mmol). The reaction mixture was stirred for 10 min at 20° C. An excess of HCl.NH₂—Sta-NH(CH₂)₂Ph 6 (196 mg, 0.621 mmol) was added and the resulting suspension was allowed to stir for 18 h at 20° C. The reaction mixture was quenched with 10% citric acid solution. The resultant precipitate was filtered off to obtain 7 as an off-white solid (196 mg, 99%). 1H NMR (600 MHz, MeOD) δ 7.30-7.15 (m, 5H), 4.00-3.90 (m, 2H), 3.81 (d, J=6.8 Hz, 1H), 3.40 (t, J=7.4 Hz, 2H), 2.80 (t, J=7.4 Hz, 2H), 2.31-2.20 (m, 2H), 2.10-2.01 (m, 1H), 1.68-1.51 (m, 2H), 1.45 (s, 9H), 1.37-1.27 (m, 1H), 0.96 (dd, J=23.0, 6.8 Hz, 6H), 0.91 (dd, J=12.6, 6.6 Hz, 6H). 13C NMR (75 MHz, MeOD) δ 174.56, 173.86, 158.20, 140.52, 129.78, 129.48, 127.32, 80.79, 71.14, 62.44, 52.28, 42.04, 41.76, 41.68, 36.49, 31.30, 28.75, 25.81, 23.69, 22.32, 19.99, 18.52. MS, m/z=478.6 [M+H]⁺.

Compound 8 HCl.NH₂—Val-Sta-NH(CH₂)₂Ph (8)

A mixture of Boc-Val-Sta-NH(CH₂)₂Ph 7 (170 mg, 0.356 mmol), in 4N HCl in dioxane (0.8 mL) was allowed to stir for 1 h at 20° C. The reaction mixture was concentrated to dryness in vacuo. The oil was triturated with Et₂O and the supernatant decanted to obtain 8 as a dull yellow solid (145 mg, 99% yield). 1H NMR (600 MHz, MeOD) δ 7.31-7.16 (m, 5H), 4.03-3.95 (m, 2H), 3.80 (d, J=4.8 Hz, 1H), 3.51-3.42 (m, 2H), 2.83 (t, J=7.4 Hz, 2H), 2.42-2.23 (m, 3H), 1.72-1.63 (m, 1H), 1.58-1.51 (m, 1H), 1.43-1.36 (m, 1H), 1.08 (dd, J=38.2, 6.9 Hz, 6H), 0.94 (dd, J=14.4, 6.6 Hz, 6H). ¹³C NMR (75 MHz, MeOD) δ 174.76, 169.66, 140.13, 129.78, 129.52, 127.44, 71.03, 59.69, 53.45, 42.64, 41.11, 40.97, 36.17, 31.56, 25.73, 23.66, 22.40, 19.28, 17.51. MS, m/z=378.4 [M+H]⁺.

Compound 9 Cbz-Cav(N,N-Boc)-Val-Sta-NH(CH₂)₂Ph (9)

To a stirred solution of Cbz-Cav(N,N-Boc)-OH 5 (50 mg, 0.122 mmol) in DMF (1 mL) was added HBTU (60 mg, 0.158 mmol) and DIPEA (127 μL, 0.731 mmol). The reaction mixture was stirred for 10 min at 20° C. An excess of HCl.NH₂—Val-Sta-NH(CH₂)₂Ph 8 (61 mg, 0.146 mmol) was added and the resulting suspension was allowed to stir for 18 h at 20° C. The reaction mixture was quenched with 10% citric acid solution and extracted with EtOAc (2×10 mL). The combined organic layers were then washed with saturated NaHCO₃ solution (1×20 mL). The organic layer was washed with brine (20 mL), dried with MgSO₄ and the solvent was concentrated in vacuo to obtain a crude residue. The crude residue was subjected to silica chromatography gradient eluting with 100% DCM to 10% MeOH/DCM to obtain 9 as a colourless oil (52 mg, 55%). 1H NMR (600 MHz, CDCl₃) δ 7.42 (br s, 1H), 7.35-7.26 (m, 7H), 7.24-7.14 (m, 3H), 6.86 (br s, 1H), 6.62 (br s, 1H), 6.25 (br s, 1H), 6.09 (br s, 1H), 5.14-5.03 (m, 2H), 4.42-4.31 (m, 1H), 4.23 (t, J=6.9 Hz, 1H), 4.03-3.78 (m, 4H), 3.56-3.37 (m, 2H), 2.80 (t, J=7.3 Hz, 2H), 2.39-1.85 (m, 5H), 1.62-1.51 (m, 2H), 1.51-1.41 (m, 9H), 1.39-1.30 (m, 1H), 0.99-0.79 (m, 12H). ¹³C NMR (75 MHz, CDCl₃) δ 172.46, 172.38, 171.58, 157.83, 156.64, 152.76, 139.12, 136.45, 128.87, 128.71, 128.36, 128.12, 127.95, 126.59, 83.45, 71.24, 70.72, 67.30, 60.38, 53.00, 51.69, 41.09, 40.83, 35.77, 32.36, 30.50, 28.39, 28.23, 25.06, 23.23, 22.29, 19.57, 18.32. MS, m/z=770.5 [M+H]⁺.

WEHI-842 Cbz-Cav(NH₂)—Val-Sta-NH(CH₂)₂Ph.TFA (WEHI-842)

A mixture of Cbz-Cav(N,N-Boc)-Val-Sta-NH(CH₂)₂Ph 9 (52 mg, 0.068 mmol), in TFA (0.8 mL) and DCM (0.8 mL) was allowed to stir for 18 h at 20° C. The reaction mixture was concentrated to dryness in vacuo. The oil was triturated with Et₂O and the supernatant decanted to obtain WEHI-842 as a colourless hygroscopic residue (52 mg, 98%). ¹H NMR (600 MHz, MeOD) δ 7.40-7.14 (m, 10H), 5.11 (s, 2H), 4.43-4.26 (m, 1H), 4.26-4.12 (m, 1H), 4.01-3.89 (m, 3H), 3.46-3.33 (m, 2H), 2.86-2.70 (m, 2H), 2.65-2.48 (m, 1H), 2.32-1.90 (m, 4H), 1.68-1.43 (m, 2H), 1.40-1.23 (m, 1H), 1.02-0.77 (m, 12H). 13C NMR (75 MHz, MeOD) δ 174.14, 173.96, 173.55, 160.45, 158.51, 140.48, 137.98, 129.77, 129.70, 129.50, 129.47, 129.10, 128.86, 127.33, 74.53, 71.28, 67.92, 60.80, 53.34, 52.87, 42.06, 41.56, 41.21, 36.50, 31.73, 31.49, 25.86, 23.71, 22.30, 19.97, 18.66. MS, m/z=670.5 [M+H]⁺. HRMS found: (M+H) 670.3925; C₃₄H₅₁N₇O₇ require (M+H), 670.3928.

The disclosure of all publications referred to in this application are incorporated herein by reference.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

### CITATION LIST

Adams, P. D., et al. PHENIX: a comprehensive Python-based system for macromolecular structure solution. Acta Cryst. D. Biol. Crystallogr. 66, 213-221 (2010).
Athauda S. B., et al. (2004) Enzymic and structural characterization of nepenthesin, a unique member of a novel subfamily of aspartic proteinases. Biochem. J. 381(Pt 1):295-306.
Ausubel et al. (1999) Short Protocols in Molecular Biology, 4^{th} Ed, John Wiley & Sons, Inc.; and the full version entitled Current Protocols in Molecular Biology.
Baldwin, E. T., et al. (1993) Crystal structure of native and inhibited forms of human cathepspin D: implications for lysosomal targeting and drug discovery. Proc. Natl. Acad. Sci. USA 90:6796-6800.
Bartlett et al. (1989) Royal Chem. Soc., 78, 182-196.
Beck J. R., Muralidharan V., Oksman A., & Goldberg D. E. (2014) PTEX component HSP101 mediates export of diverse malaria effectors into host erythrocytes. Nature 511(7511):592-595.
Bentley (1997) Methods Enzymol., 276, 611-619.
Binz et al. (2005) Nature Biotech., 23, 1257-1268.
Blanc, E., Roversi, P., Vonrhein, C., Flensburg, C., Lea, S. M., and Bricogne, G. (2004). Refinement of severely incomplete structures with maximum likelihood in BUSTER-TNT. Acta Crystallogr D Biol Crystallogr 60, 2210-2221.
Blondelle and Houghten (1996) Trends Biotechnol., 14, 60-65.
Boddey J. A. & Cowman A. F. (2013) Plasmodium nesting: remaking the erythrocyte from the inside out. Annu. Rev. Microbiol. 67:243-269.
Boddey J. A., et al. (2010) An aspartyl protease directs malaria effector proteins to the host cell. Nature 463(7281):627-631.
Boddey J. A., et al. (2013) Role of Plasmepsin V in export of diverse protein families from the Plasmodium falciparum exportome. Traffic.
Boddey J. A., Moritz R. L., Simpson R. J., & Cowman A. F. (2009) Role of the Plasmodium export element in trafficking parasite proteins to the infected erythrocyte. Traffic 10(3):285-299.
Bohm and Stahl (1999) M. Med. Chem. Res., 9, 445.
Brooks et al. (1983) Comp. Chem., 4, 187-217.
Bruns et al. (1999) J Mol Biol., 288, 427-439.
Bunkoczi, G. & Read, R. J. Improvement of molecular-replacement models with Sculptor. Acta Crystallogr. D. Biol. Crystallogr. 67, 303-12 (2011).
Carell et al. (1994a) Angew. Chem. Int. Ed. Engl., 33, 2059.
Carell et al. (1994b) Angew. Chem. Int. Ed. Engl., 33, 2061.
Chang H. H., et al. (2008)N-terminal processing of proteins exported by malaria parasites. Mol. Biochem. Parasitol. 160(2):107-115.
Cho et al. (1993) Science, 261, 1303.
Cohen et al. (1990) J. Med. Chem., 33, 883-894.
Cole et al. (2005) in “Virtual Screening in Drug Discovery (Eds. B. Shoichet, J. Alvarez)”, Taylor & Francis CRC Press, Florida, USA.
Cull et al. (1992) Proc. Natl. Acad. Sci. USA, 89, 1865-1869.
Cwirla et al. (1990) Proc. Natl. Acad. Sci. USA, 97, 6378-6382.
Day and Caflisch (2008) J. Chem. Inform. Model. 48, 679-90.
Devlin (1990) Science, 249, 404-406.
DeWitt et al. (1993) Proc. Natl. Acad. Sci. USA, 90, 6909.
Elsworth B., et al. (2014) PTEX is an essential nexus for protein export in malaria parasites. Nature 511(7511):587-591.
Emsley, P. & Cowtan, K. Coot: model-building tools for molecular graphics. Acta Cryst. D. Biol. Crystallogr. 60, 2126-2132 (2004).
Erb et al. (1994) Proc. Natl. Acad. Sci. USA, 91, 11422.
Evans, P. R. & Murshudov, G. N. How good are my data and what is the resolution? Acta Crystallogr. D. Biol. Crystallogr. 69, 1204-1214 (2013).
Evans, P. R. An introduction to data reduction: space-group determination, scaling and intensity statistics. Acta Crystallogr. D. Biol. Crystallogr. 67, 282-292 (2011).
Ewing et al. (2001) J. Comput-Aid. Mol. Design, 15, 411.
Felici (1991) J. Mol. Biol., 222, 301-310.
Fodor (1993) Nature, 364, 555-556.
Friesner et al. (2004) J. Med. Chem. 47, 1739-1749/Gallop et al. (1994). J. Med. Chem., 37, 1233.
Gazdik M. et al. (2015) The effect of N-methylation on transition state mimetic inhibitors of the Plasmodium protease, plasmepsin V. Med. Chem. Comm. 6:437-443.
Ghosh, A. K., et al. (2001) Structure-based design: Potent inhibitors of human brain memapsin 2 (β-secretase). J. Med. Chem. 44(18):2865-2868.
Goodford (1985) J. Med. Chem., 28, 849-857 (1985).
Goodsell and Olsen (1990) Proteins: Struct. Funct. Genet., 8, 195-202.
Green M R and Sambrook J, Molecular Cloning: A Laboratory Manual, 4^{th} Edition, Cold Spring Harbor Laboratory, 2012.
Guida (1994) Curr. Opin. Struct. Biol., 4, 777-781.
Haque, T. S., et al. (1999) Potent, low-molecular-weight non-peptide inhibitors of malarial aspartyl protease plasmepsin II. J. Med. Chem. 42(8):1428-1440.
Hiller N. L., et al. (2004) A host-targeting signal in virulence proteins reveals a secretome in malarial infection. Science 306(5703):1934-1937.
Houghten (1992) Biotechniques, 13, 412-421.
James, M. N. & Sielecki, A. R. (1983) Structure and refinement of penicillopepsin at 1.8 A resolution. J. Mol. Biol. 163(2):299-361.
Johansson, P. O., et al. (2005) Design and synthesis of potent inhibitors of plasmepsin I and II: X-ray crystal structure of inhibitor in complex with plasmepsin II. J. Med. Chem. 48(13):4400-4409.
Jones et al. (1991) Acta Cryst. A 47, 110-119.
Jones, T. A., and Thirup, S. (1986). Using known substructures in protein model building and crystallography. EMBO J 5, 819-822.
Jorgensen and Tirado-Rives (1988) Am. Chem. Soc., 110, 1657-1666.
Kabsch, W. Xds. Acta Crystallogr D Biol Crystallogr 66, 125-132 (2010).
Kay J et al. (2011) The aspartic proteinase family of three Phytophthora species. BMC Genomics 12:254.
Klemba M. & Goldberg D. E. (2005) Characterization of plasmepsin V, a membrane-bound aspartic protease homolog in the endoplasmic reticulum of Plasmodium falciparum. Mol. Biochem. Parasitol. 143(2):183-191.
Kuntz et al. (1982) J. Mol. Biol., 161, 269-288.
Lam (1997) Anticancer Drug Des., 12, 145.
Lam et al. (1991) Nature, 354, 82-84.
Lattman (1985) Use of the Rotation and Translation Functions, Meth. Enzymol., 115, 55-77.
Marti M., Good R. T., Rug M., Knuepfer E., & Cowman A. F. (2004) Targeting malaria virulence and remodeling proteins to the host erythrocyte. Science 306(5703):1930-1933.
McCoy, A. J. et al. Phaser crystallographic software. J. Appl. Cryst. 40, 658-674 (2007).
Morton and Myszka (1998) Methods Enzymol., 295, 268-294.
Navaza and Saludjian (1997) Methods Enzymol., 276, 581-594.
Navia and Murcko (1992) Curr. Opin. Struct. Biol., 2, 202-210.
Nice and Catimel (1999) Bioessays, 21, 339-352.
Ostermann, N., Gerhartz, B., Worpenberg, S., Trappe, J. & Eder, J. Crystal structure of an activation intermediate of cathepsin E. J. Mol. Biol. 342, 889-899 (2004).
Rarey et al. (1996) J. Mol. Biol., 261, 470.
Robert, X. & Gouet, P. (2014) Nucleic Acids Res., 42, W320-324.
Rossmann, ed. (1972) The Molecular Replacement Method, Int. Sci. Rev. Ser., No. 13, Gordon & Breach, New York.
Russo I., et al. (2010) Plasmepsin V licenses Plasmodium proteins for export into the host erythrocyte. Nature 463(7281):632-636.
Sali and Blundell (1993) J. Mol. Biol., 234, 779-815.
Sambrook et al. (2001) Molecular Cloning: A Laboratory Manual, 3^{rd} ed. Cold Spring Harbor Laboratory Press, Cold Spring Harbor, N.Y.
Sargeant T. J., et al. (2006) Lineage-specific expansion of proteins exported to erythrocytes in malaria parasites. Genome Biol. 7(2):R12.
Schulze J., et al. (2015) The Plasmodium falciparum exportome contains non-canonical PEXEL/HT proteins. Mol. Microbiol.
Scott and Smith (1990) Science, 249, 386-390.
Silverman et al. (2005) Nature Biotech., 23, 1556-1561.
Sleebs B. E., et al. (2013) Discovery of potent and selective benzothiazole hydrazone inhibitors of Bcl-XL. J. Med. Chem. 56(13):5514-5540.
Sleebs B. E., et al. (2014) Inhibition of Plasmepsin V activity demonstrates its essential role in protein export, PfEMP1 display, and survival of malaria parasites. PLoS biology 12(7):e1001897. (“Sleebs, B. E. et al, 2014a”)
Sleebs, B. E. et al., Transition State Mimetics of the Plasmodium Export Element Are Potent Inhibitors of Plasmepsin V from P. falciparum and P. vivax. J. Med. Chem. 57, 7644-7662 (2014) (“Sleebs, B. E. et al, 2014b”).
Stumpp et al. (2007) Curr. Opin. Drug Discov. Develop., 10, 153-159.
Tong and Rossmann, (1997) Methods Enzymol., 276, 594-611.
Ulrich (2006) Handb Exp Pharmacol., 173, 305-326. van der Spoel et al. (2005) J. Comp. Chem., 26, 1701-1718.
Weiner et al. (1984) J. Am. Chem. Soc., 106, 765-784.
Xiao, H. et al. The zymogen of plasmepsin V from Plasmodium falciparum is enzymatically active. Mol. Biochem. Parasitol. 197, 56-63 (2014).
Zuckermann et al. (1994) J. Med. Chem., 37, 2678.

APPENDIX I
ATOMIC COORDINATES PLASMEPSIN V (CHAINS A AND B) WITH WEHI-842 (CHAIN C)

| | | | | | | | | | | | | |
|---|---|---|---|---|---|---|---|---|---|---|---|---|
| ATOM | 1 | O | LYS | A | 44 | 25.379 | 78.300 | 45.778 | 1.00 | 59.22 | | O |
| ANISOU | 1 | O | LYS | A | 44 | 5853 | 6697 | 9953 | 834 | −1178 | 910 | O |
| ATOM | 2 | N | LYS | A | 44 | 26.289 | 80.851 | 48.120 | 1.00 | 70.33 | | N |
| ANISOU | 2 | N | LYS | A | 44 | 7294 | 8382 | 11045 | 590 | −1616 | 1047 | N |
| ATOM | 3 | CA | LYS | A | 44 | 26.627 | 79.768 | 47.206 | 1.00 | 71.12 | | C |
| ANISOU | 3 | CA | LYS | A | 44 | 7240 | 8341 | 11442 | 727 | −1503 | 998 | C |
| ATOM | 4 | C | LYS | A | 44 | 25.357 | 79.281 | 46.521 | 1.00 | 61.96 | | C |
| ANISOU | 4 | C | LYS | A | 44 | 6270 | 7165 | 10108 | 730 | −1282 | 959 | C |
| ATOM | 5 | CB | LYS | A | 44 | 27.316 | 78.614 | 47.947 | 1.00 | 73.16 | | C |
| ANISOU | 5 | CB | LYS | A | 44 | 7486 | 8475 | 11835 | 779 | −1709 | 1088 | C |
| ATOM | 6 | CG | LYS | A | 44 | 28.512 | 78.032 | 47.210 | 1.00 | 76.22 | | C |
| ANISOU | 6 | CG | LYS | A | 44 | 7632 | 8759 | 12570 | 877 | −1624 | 970 | C |
| ATOM | 7 | CD | LYS | A | 44 | 29.601 | 77.584 | 48.187 | 1.00 | 83.07 | | C |
| ANISOU | 7 | CD | LYS | A | 44 | 8424 | 9559 | 13580 | 891 | −1891 | 1054 | C |
| ATOM | 8 | CE | LYS | A | 44 | 30.885 | 77.216 | 47.452 | 1.00 | 87.12 | | C |
| ANISOU | 8 | CE | LYS | A | 44 | 8668 | 9984 | 14448 | 977 | −1802 | 922 | C |
| ATOM | 9 | NZ | LYS | A | 44 | 31.346 | 78.331 | 46.574 | 1.00 | 87.82 | | N |
| ANISOU | 9 | NZ | LYS | A | 44 | 8594 | 10174 | 14599 | 943 | −1586 | 767 | N |
| ATOM | 10 | O | ASP | A | 45 | 23.433 | 80.947 | 44.272 | 1.00 | 40.49 | | O |
| ANISOU | 10 | O | ASP | A | 45 | 3791 | 4659 | 6935 | 597 | −642 | 667 | O |
| ATOM | 11 | N | ASP | A | 45 | 24.248 | 79.961 | 46.807 | 1.00 | 53.17 | | N |
| ANISOU | 11 | N | ASP | A | 45 | 5390 | 6169 | 8644 | 617 | −1221 | 971 | N |
| ATOM | 12 | CA | ASP | A | 45 | 22.955 | 79.618 | 46.218 | 1.00 | 51.18 | | C |
| ANISOU | 12 | CA | ASP | A | 45 | 5316 | 5916 | 8213 | 603 | −1028 | 933 | C |
| ATOM | 13 | C | ASP | A | 45 | 22.917 | 79.923 | 44.731 | 1.00 | 42.82 | | C |
| ANISOU | 13 | C | ASP | A | 45 | 4180 | 4873 | 7218 | 634 | −740 | 756 | C |
| ATOM | 14 | CB | ASP | A | 45 | 21.810 | 80.405 | 46.870 | 1.00 | 60.38 | | C |
| ANISOU | 14 | CB | ASP | A | 45 | 6718 | 7211 | 9013 | 475 | −1022 | 969 | C |
| ATOM | 15 | CG | ASP | A | 45 | 21.512 | 79.966 | 48.284 | 1.00 | 68.31 | | C |
| ANISOU | 15 | CG | ASP | A | 45 | 7868 | 8212 | 9874 | 425 | −1257 | 1144 | C |
| ATOM | 16 | OD1 | ASP | A | 45 | 21.919 | 78.846 | 48.668 | 1.00 | 62.72 | | O |
| ANISOU | 16 | OD1 | ASP | A | 45 | 7121 | 7378 | 9330 | 492 | −1416 | 1261 | O |
| ATOM | 17 | OD2 | ASP | A | 45 | 20.829 | 80.746 | 48.994 | 1.00 | 75.00 | | O |
| ANISOU | 17 | OD2 | ASP | A | 45 | 8879 | 9180 | 10437 | 314 | −1272 | 1162 | O |
| ATOM | 18 | N | LEU | A | 46 | 22.228 | 79.067 | 43.996 | 1.00 | 39.53 | | N |
| ANISOU | 18 | N | LEU | A | 46 | 3826 | 4383 | 6812 | 684 | −606 | 708 | N |
| ATOM | 19 | CA | LEU | A | 46 | 21.985 | 79.293 | 42.591 | 1.00 | 35.21 | | C |
| ANISOU | 19 | CA | LEU | A | 46 | 3261 | 3861 | 6256 | 698 | −339 | 545 | C |
| ATOM | 20 | C | LEU | A | 46 | 20.949 | 80.402 | 42.433 | 1.00 | 29.52 | | C |
| ANISOU | 20 | C | LEU | A | 46 | 2716 | 3277 | 5225 | 588 | −235 | 517 | C |
| ATOM | 21 | O | LEU | A | 46 | 19.843 | 80.299 | 42.964 | 1.00 | 30.00 | | O |
| ANISOU | 21 | O | LEU | A | 46 | 2953 | 3359 | 5088 | 537 | −280 | 581 | O |
| ATOM | 22 | CB | LEU | A | 46 | 21.512 | 78.001 | 41.929 | 1.00 | 33.53 | | C |
| ANISOU | 22 | CB | LEU | A | 46 | 3077 | 3521 | 6141 | 778 | −257 | 497 | C |
| ATOM | 23 | CG | LEU | A | 46 | 21.310 | 78.092 | 40.422 | 1.00 | 36.15 | | C |
| ANISOU | 23 | CG | LEU | A | 46 | 3400 | 3875 | 6458 | 796 | 10 | 316 | C |
| ATOM | 24 | CD1 | LEU | A | 46 | 22.570 | 78.634 | 39.733 | 1.00 | 30.22 | | C |
| ANISOU | 24 | CD1 | LEU | A | 46 | 2443 | 3158 | 5882 | 826 | 132 | 210 | C |
| ATOM | 25 | CD2 | LEU | A | 46 | 20.908 | 76.746 | 39.852 | 1.00 | 28.94 | | C |
| ANISOU | 25 | CD2 | LEU | A | 46 | 2512 | 2821 | 5662 | 876 | 65 | 253 | C |
| ATOM | 26 | N | LEU | A | 47 | 21.304 | 81.455 | 41.701 | 1.00 | 28.55 | | N |
| ANISOU | 26 | N | LEU | A | 47 | 2537 | 3238 | 5074 | 551 | −93 | 424 | N |
| ATOM | 27 | CA | LEU | A | 47 | 20.399 | 82.608 | 41.509 | 1.00 | 24.72 | | C |
| ANISOU | 27 | CA | LEU | A | 47 | 2203 | 2863 | 4326 | 455 | −8 | 399 | C |
| ATOM | 28 | C | LEU | A | 47 | 20.036 | 82.816 | 40.037 | 1.00 | 27.51 | | C |
| ANISOU | 28 | C | LEU | A | 47 | 2589 | 3239 | 4625 | 458 | 225 | 278 | C |
| ATOM | 29 | O | LEU | A | 47 | 20.925 | 82.947 | 39.201 | 1.00 | 24.28 | | O |
| ANISOU | 29 | O | LEU | A | 47 | 2050 | 2827 | 4349 | 481 | 352 | 201 | O |
| ATOM | 30 | CB | LEU | A | 47 | 21.038 | 83.889 | 42.041 | 1.00 | 24.72 | | C |
| ANISOU | 30 | CB | LEU | A | 47 | 2149 | 2942 | 4304 | 382 | −72 | 418 | C |
| ATOM | 31 | CG | LEU | A | 47 | 21.513 | 83.961 | 43.491 | 1.00 | 28.19 | | C |
| ANISOU | 31 | CG | LEU | A | 47 | 2562 | 3386 | 4763 | 356 | −316 | 523 | C |
| ATOM | 32 | CD1 | LEU | A | 47 | 22.090 | 85.352 | 43.780 | 1.00 | 25.80 | | C |
| ANISOU | 32 | CD1 | LEU | A | 47 | 2207 | 3158 | 4436 | 272 | −348 | 502 | C |
| ATOM | 33 | CD2 | LEU | A | 47 | 20.380 | 83.630 | 44.441 | 1.00 | 24.40 | | C |
| ANISOU | 33 | CD2 | LEU | A | 47 | 2276 | 2922 | 4073 | 321 | −423 | 608 | C |
| ATOM | 34 | N | TYR | A | 48 | 18.741 | 82.853 | 39.720 | 1.00 | 28.79 | | N |
| ANISOU | 34 | N | TYR | A | 48 | 2923 | 3426 | 4590 | 430 | 279 | 261 | N |
| ATOM | 35 | CA | TYR | A | 48 | 18.290 | 83.244 | 38.378 | 1.00 | 22.85 | | C |
| ANISOU | 35 | CA | TYR | A | 48 | 2236 | 2711 | 3735 | 414 | 464 | 163 | C |
| ATOM | 36 | C | TYR | A | 48 | 17.821 | 84.684 | 38.451 | 1.00 | 28.73 | | C |
| ANISOU | 36 | C | TYR | A | 48 | 3069 | 3544 | 4302 | 327 | 471 | 182 | C |
| ATOM | 37 | O | TYR | A | 48 | 16.986 | 85.016 | 39.294 | 1.00 | 25.63 | | O |
| ANISOU | 37 | O | TYR | A | 48 | 2774 | 3176 | 3787 | 290 | 369 | 235 | O |
| ATOM | 38 | CB | TYR | A | 48 | 17.160 | 82.346 | 37.856 | 1.00 | 21.37 | | C |
| ANISOU | 38 | CB | TYR | A | 48 | 2167 | 2483 | 3469 | 442 | 505 | 120 | C |
| ATOM | 39 | CG | TYR | A | 48 | 17.556 | 80.922 | 37.520 | 1.00 | 25.69 | | C |
| ANISOU | 39 | CG | TYR | A | 48 | 2640 | 2922 | 4200 | 530 | 528 | 70 | C |
| ATOM | 40 | CD1 | TYR | A | 48 | 18.884 | 80.501 | 37.587 | 1.00 | 26.14 | | C |
| ANISOU | 40 | CD1 | TYR | A | 48 | 2517 | 2923 | 4492 | 593 | 528 | 56 | C |
| ATOM | 41 | CD2 | TYR | A | 48 | 16.594 | 79.992 | 37.125 | 1.00 | 29.48 | | C |
| ANISOU | 41 | CD2 | TYR | A | 48 | 3217 | 3343 | 4642 | 552 | 546 | 26 | C |
| ATOM | 42 | CE1 | TYR | A | 48 | 19.242 | 79.187 | 37.272 | 1.00 | 25.63 | | C |
| ANISOU | 42 | CE1 | TYR | A | 48 | 2374 | 2736 | 4626 | 687 | 549 | −4 | C |
| ATOM | 43 | CE2 | TYR | A | 48 | 16.943 | 78.679 | 36.816 | 1.00 | 23.16 | | C |
| ANISOU | 43 | CE2 | TYR | A | 48 | 2351 | 2421 | 4028 | 634 | 564 | −33 | C |
| ATOM | 44 | CZ | TYR | A | 48 | 18.263 | 78.288 | 36.892 | 1.00 | 24.76 | | C |
| ANISOU | 44 | CZ | TYR | A | 48 | 2379 | 2560 | 4467 | 706 | 567 | −49 | C |
| ATOM | 45 | OH | TYR | A | 48 | 18.596 | 76.997 | 36.587 | 1.00 | 31.07 | | O |
| ANISOU | 45 | OH | TYR | A | 48 | 3107 | 3221 | 5478 | 797 | 584 | −118 | O |
| ATOM | 46 | N | LYS | A | 49 | 18.383 | 85.536 | 37.593 | 1.00 | 28.99 | | N |
| ANISOU | 46 | N | LYS | A | 49 | 3065 | 3616 | 4333 | 293 | 595 | 138 | N |
| ATOM | 47 | CA | LYS | A | 49 | 18.116 | 86.983 | 37.625 | 1.00 | 28.65 | | C |
| ANISOU | 47 | CA | LYS | A | 49 | 3091 | 3631 | 4164 | 210 | 596 | 162 | C |
| ATOM | 48 | C | LYS | A | 49 | 17.336 | 87.470 | 36.398 | 1.00 | 29.88 | | C |
| ANISOU | 48 | C | LYS | A | 49 | 3379 | 3813 | 4161 | 183 | 721 | 121 | C |
| ATOM | 49 | O | LYS | A | 49 | 17.650 | 87.101 | 35.256 | 1.00 | 29.82 | | O |
| ANISOU | 49 | O | LYS | A | 49 | 3363 | 3807 | 4159 | 198 | 864 | 62 | O |
| ATOM | 50 | CB | LYS | A | 49 | 19.430 | 87.765 | 37.754 | 1.00 | 20.94 | | C |
| ANISOU | 50 | CB | LYS | A | 49 | 1971 | 2667 | 3319 | 166 | 612 | 174 | C |
| ATOM | 51 | CG | LYS | A | 49 | 20.077 | 87.616 | 39.117 | 1.00 | 29.26 | | C |
| ANISOU | 51 | CG | LYS | A | 49 | 2919 | 3706 | 4493 | 172 | 434 | 227 | C |
| ATOM | 52 | CD | LYS | A | 49 | 21.464 | 88.219 | 39.168 | 1.00 | 30.50 | | C |
| ANISOU | 52 | CD | LYS | A | 49 | 2897 | 3866 | 4826 | 134 | 443 | 225 | C |
| ATOM | 53 | CE | LYS | A | 49 | 22.001 | 88.254 | 40.594 | 1.00 | 33.19 | | C |
| ANISOU | 53 | CE | LYS | A | 49 | 3159 | 4200 | 5253 | 125 | 223 | 282 | C |
| ATOM | 54 | NZ | LYS | A | 49 | 23.244 | 89.103 | 40.715 | 1.00 | 34.58 | | N |
| ANISOU | 54 | NZ | LYS | A | 49 | 3164 | 4383 | 5591 | 63 | 207 | 274 | N |
| ATOM | 55 | N | TYR | A | 50 | 16.315 | 88.291 | 36.646 | 1.00 | 19.44 | | N |
| ANISOU | 55 | N | TYR | A | 50 | 2178 | 2511 | 2696 | 143 | 660 | 148 | N |
| ATOM | 56 | CA | TYR | A | 50 | 15.468 | 88.823 | 35.578 | 1.00 | 20.10 | | C |
| ANISOU | 56 | CA | TYR | A | 50 | 2395 | 2611 | 2631 | 121 | 730 | 129 | C |
| ATOM | 57 | C | TYR | A | 50 | 15.463 | 90.347 | 35.606 | 1.00 | 24.43 | | C |
| ANISOU | 57 | C | TYR | A | 50 | 2985 | 3168 | 3129 | 50 | 715 | 171 | C |
| ATOM | 58 | O | TYR | A | 50 | 15.353 | 90.932 | 36.679 | 1.00 | 29.04 | | O |
| ANISOU | 58 | O | TYR | A | 50 | 3553 | 3746 | 3734 | 29 | 610 | 196 | O |
| ATOM | 59 | CB | TYR | A | 50 | 14.043 | 88.269 | 35.731 | 1.00 | 17.54 | | C |
| ANISOU | 59 | CB | TYR | A | 50 | 2174 | 2279 | 2213 | 154 | 660 | 113 | C |
| ATOM | 60 | CG | TYR | A | 50 | 14.037 | 86.767 | 35.954 | 1.00 | 18.24 | | C |
| ANISOU | 60 | CG | TYR | A | 50 | 2218 | 2334 | 2378 | 214 | 649 | 84 | C |
| ATOM | 61 | CD1 | TYR | A | 50 | 14.129 | 85.883 | 34.877 | 1.00 | 17.78 | | C |
| ANISOU | 61 | CD1 | TYR | A | 50 | 2172 | 2259 | 2327 | 250 | 745 | 15 | C |
| ATOM | 62 | CD2 | TYR | A | 50 | 13.984 | 86.235 | 37.229 | 1.00 | 17.09 | | C |
| ANISOU | 62 | CD2 | TYR | A | 50 | 2029 | 2169 | 2297 | 228 | 542 | 126 | C |
| ATOM | 63 | CE1 | TYR | A | 50 | 14.136 | 84.533 | 35.070 | 1.00 | 20.31 | | C |
| ANISOU | 63 | CE1 | TYR | A | 50 | 2451 | 2524 | 2742 | 306 | 730 | −16 | C |
| ATOM | 64 | CE2 | TYR | A | 50 | 14.000 | 84.846 | 37.439 | 1.00 | 17.28 | | C |
| ANISOU | 64 | CE2 | TYR | A | 50 | 2019 | 2139 | 2408 | 279 | 521 | 120 | C |
| ATOM | 65 | CZ | TYR | A | 50 | 14.070 | 84.017 | 36.351 | 1.00 | 17.86 | | C |
| ANISOU | 65 | CZ | TYR | A | 50 | 2094 | 2178 | 2514 | 321 | 614 | 45 | C |
| ATOM | 66 | OH | TYR | A | 50 | 14.097 | 82.658 | 36.510 | 1.00 | 27.51 | | O |
| ANISOU | 66 | OH | TYR | A | 50 | 3283 | 3324 | 3847 | 374 | 593 | 30 | O |
| ATOM | 67 | N | LYS | A | 51 | 15.590 | 90.987 | 34.445 | 1.00 | 27.82 | | N |
| ANISOU | 67 | N | LYS | A | 51 | 3476 | 3605 | 3489 | 8 | 817 | 179 | N |
| ATOM | 68 | CA | LYS | A | 51 | 15.534 | 92.455 | 34.363 | 1.00 | 25.55 | | C |
| ANISOU | 68 | CA | LYS | A | 51 | 3243 | 3300 | 3164 | −62 | 799 | 232 | C |
| ATOM | 69 | C | LYS | A | 51 | 14.146 | 93.019 | 34.616 | 1.00 | 26.12 | | C |
| ANISOU | 69 | C | LYS | A | 51 | 3433 | 3348 | 3143 | −48 | 687 | 242 | C |
| ATOM | 70 | O | LYS | A | 51 | 13.163 | 92.563 | 34.020 | 1.00 | 23.74 | | O |
| ANISOU | 70 | O | LYS | A | 51 | 3223 | 3053 | 2745 | −11 | 676 | 222 | O |
| ATOM | 71 | CB | LYS | A | 51 | 16.004 | 92.938 | 32.996 | 1.00 | 25.76 | | C |
| ANISOU | 71 | CB | LYS | A | 51 | 3327 | 3337 | 3124 | −121 | 941 | 259 | C |
| ATOM | 72 | CG | LYS | A | 51 | 17.494 | 92.770 | 32.775 | 1.00 | 28.84 | | C |
| ANISOU | 72 | CG | LYS | A | 51 | 3575 | 3747 | 3636 | −159 | 1078 | 249 | C |
| ATOM | 73 | CD | LYS | A | 51 | 17.919 | 93.333 | 31.445 | 1.00 | 31.16 | | C |
| ANISOU | 73 | CD | LYS | A | 51 | 3940 | 4060 | 3840 | −240 | 1243 | 283 | C |
| ATOM | 74 | CE | LYS | A | 51 | 19.368 | 92.962 | 31.158 | 1.00 | 31.74 | | C |
| ANISOU | 74 | CE | LYS | A | 51 | 3847 | 4164 | 4050 | −271 | 1415 | 245 | C |
| ATOM | 75 | NZ | LYS | A | 51 | 19.869 | 93.711 | 29.977 | 1.00 | 39.41 | | N |
| ANISOU | 75 | NZ | LYS | A | 51 | 4885 | 5158 | 4932 | −381 | 1595 | 294 | N |
| ATOM | 76 | N | LEU | A | 52 | 14.068 | 94.023 | 35.485 | 1.00 | 24.02 | | N |
| ANISOU | 76 | N | LEU | A | 52 | 3155 | 3050 | 2920 | −79 | 602 | 259 | N |
| ATOM | 77 | CA | LEU | A | 52 | 12.827 | 94.784 | 35.642 | 1.00 | 28.43 | | C |
| ANISOU | 77 | CA | LEU | A | 52 | 3809 | 3570 | 3422 | −67 | 512 | 257 | C |
| ATOM | 78 | C | LEU | A | 52 | 12.986 | 96.178 | 35.047 | 1.00 | 32.70 | | C |
| ANISOU | 78 | C | LEU | A | 52 | 4413 | 4049 | 3964 | −127 | 518 | 315 | C |
| ATOM | 79 | O | LEU | A | 52 | 14.068 | 96.771 | 35.099 | 1.00 | 28.34 | | O |
| ANISOU | 79 | O | LEU | A | 52 | 3805 | 3478 | 3484 | −194 | 562 | 347 | O |
| ATOM | 80 | CB | LEU | A | 52 | 12.427 | 94.898 | 37.106 | 1.00 | 27.94 | | C |
| ANISOU | 80 | CB | LEU | A | 52 | 3706 | 3508 | 3404 | −52 | 415 | 212 | C |
| ATOM | 81 | CG | LEU | A | 52 | 12.326 | 93.630 | 37.949 | 1.00 | 27.37 | | C |
| ANISOU | 81 | CG | LEU | A | 52 | 3579 | 3486 | 3334 | −11 | 392 | 180 | C |
| ATOM | 82 | CD1 | LEU | A | 52 | 12.092 | 94.043 | 39.393 | 1.00 | 20.29 | | C |
| ANISOU | 82 | CD1 | LEU | A | 52 | 2664 | 2596 | 2448 | −27 | 307 | 145 | C |
| ATOM | 83 | CD2 | LEU | A | 52 | 11.218 | 92.721 | 37.446 | 1.00 | 15.23 | | C |
| ANISOU | 83 | CD2 | LEU | A | 52 | 2096 | 1962 | 1730 | 42 | 400 | 158 | C |
| ATOM | 84 | N | TYR | A | 53 | 11.912 | 96.677 | 34.449 | 1.00 | 29.70 | | N |
| ANISOU | 84 | N | TYR | A | 53 | 4143 | 3627 | 3515 | −107 | 465 | 336 | N |
| ATOM | 85 | CA | TYR | A | 53 | 11.890 | 98.045 | 33.954 | 1.00 | 30.49 | | C |
| ANISOU | 85 | CA | TYR | A | 53 | 4318 | 3640 | 3626 | −157 | 438 | 406 | C |
| ATOM | 86 | C | TYR | A | 53 | 10.764 | 98.775 | 34.655 | 1.00 | 24.64 | | C |
| ANISOU | 86 | C | TYR | A | 53 | 3597 | 2828 | 2936 | −112 | 311 | 365 | C |
| ATOM | 87 | O | TYR | A | 53 | 9.802 | 98.150 | 35.122 | 1.00 | 22.44 | | O |
| ANISOU | 87 | O | TYR | A | 53 | 3302 | 2582 | 2644 | −43 | 263 | 295 | O |
| ATOM | 88 | CB | TYR | A | 53 | 11.686 | 98.092 | 32.441 | 1.00 | 28.23 | | C |
| ANISOU | 88 | CB | TYR | A | 53 | 4160 | 3351 | 3214 | −177 | 478 | 485 | C |
| ATOM | 89 | CG | TYR | A | 53 | 12.602 | 97.166 | 31.705 | 1.00 | 28.96 | | C |
| ANISOU | 89 | CG | TYR | A | 53 | 4236 | 3530 | 3237 | −207 | 627 | 488 | C |
| ATOM | 90 | CD2 | TYR | A | 53 | 13.815 | 97.607 | 31.183 | 1.00 | 32.74 | | C |
| ANISOU | 90 | CD2 | TYR | A | 53 | 4701 | 4010 | 3728 | −301 | 754 | 549 | C |
| ATOM | 91 | CD1 | TYR | A | 53 | 12.256 | 95.823 | 31.541 | 1.00 | 27.86 | | C |
| ANISOU | 91 | CD1 | TYR | A | 53 | 4084 | 3463 | 3037 | −145 | 651 | 417 | C |
| ATOM | 92 | CE2 | TYR | A | 53 | 14.665 | 96.719 | 30.512 | 1.00 | 34.90 | | C |
| ANISOU | 92 | CE2 | TYR | A | 53 | 4940 | 4366 | 3955 | −322 | 915 | 526 | C |
| ATOM | 93 | CE1 | TYR | A | 53 | 13.082 | 94.945 | 30.878 | 1.00 | 31.67 | | C |
| ANISOU | 93 | CE1 | TYR | A | 53 | 4544 | 4013 | 3476 | −162 | 793 | 394 | C |
| ATOM | 94 | CZ | TYR | A | 53 | 14.283 | 95.392 | 30.368 | 1.00 | 36.69 | | C |
| ANISOU | 94 | CZ | TYR | A | 53 | 5157 | 4658 | 4125 | −246 | 930 | 442 | C |
| ATOM | 95 | OH | TYR | A | 53 | 15.085 | 94.497 | 29.711 | 1.00 | 47.34 | | O |
| ANISOU | 95 | OH | TYR | A | 53 | 6468 | 6075 | 5445 | −256 | 1092 | 395 | O |
| ATOM | 96 | N | GLY | A | 54 | 10.877 | 100.096 | 34.730 | 1.00 | 22.07 | | N |
| ANISOU | 96 | N | GLY | A | 54 | 3300 | 2399 | 2687 | −153 | 266 | 401 | N |
| ATOM | 97 | CA | GLY | A | 54 | 9.801 | 100.892 | 35.290 | 1.00 | 23.29 | | C |
| ANISOU | 97 | CA | GLY | A | 54 | 3471 | 2465 | 2914 | −103 | 153 | 349 | C |
| ATOM | 98 | C | GLY | A | 54 | 10.274 | 101.978 | 36.230 | 1.00 | 24.52 | | C |
| ANISOU | 98 | C | GLY | A | 54 | 3582 | 2537 | 3197 | −147 | 121 | 307 | C |
| ATOM | 99 | O | GLY | A | 54 | 11.472 | 102.134 | 36.450 | 1.00 | 21.99 | | O |
| ANISOU | 99 | O | GLY | A | 54 | 3214 | 2227 | 2912 | −225 | 175 | 327 | O |
| ATOM | 100 | N | ASP | A | 55 | 9.319 | 102.709 | 36.798 | 1.00 | 24.74 | | N |
| ANISOU | 100 | N | ASP | A | 55 | 3614 | 2479 | 3308 | −95 | 34 | 232 | N |
| ATOM | 101 | CA | ASP | A | 55 | 9.603 | 103.773 | 37.747 | 1.00 | 29.93 | | C |
| ANISOU | 101 | CA | ASP | A | 55 | 4239 | 3044 | 4090 | −129 | −5 | 156 | C |
| ATOM | 102 | C | ASP | A | 55 | 8.321 | 104.186 | 38.443 | 1.00 | 30.14 | | C |
| ANISOU | 102 | C | ASP | A | 55 | 4250 | 3013 | 4188 | −44 | −73 | 29 | C |
| ATOM | 103 | O | ASP | A | 55 | 7.222 | 103.795 | 38.047 | 1.00 | 23.08 | | O |
| ANISOU | 103 | O | ASP | A | 55 | 3368 | 2131 | 3273 | 36 | −102 | 23 | O |
| ATOM | 104 | CB | ASP | A | 55 | 10.231 | 104.990 | 37.055 | 1.00 | 25.27 | | C |
| ANISOU | 104 | CB | ASP | A | 55 | 3707 | 2306 | 3587 | −204 | −26 | 263 | C |
| ATOM | 105 | CG | ASP | A | 55 | 9.386 | 105.506 | 35.900 | 1.00 | 35.49 | | C |
| ANISOU | 105 | CG | ASP | A | 55 | 5107 | 3492 | 4885 | −162 | −94 | 370 | C |
| ATOM | 106 | OD1 | ASP | A | 55 | 8.157 | 105.687 | 36.073 | 1.00 | 34.33 | | O |
| ANISOU | 106 | OD1 | ASP | A | 55 | 4962 | 3293 | 4790 | −66 | −179 | 303 | O |
| ATOM | 107 | OD2 | ASP | A | 55 | 9.949 | 105.727 | 34.809 | 1.00 | 41.61 | | O |
| ANISOU | 107 | OD2 | ASP | A | 55 | 5962 | 4236 | 5610 | −230 | −64 | 523 | O |
| ATOM | 108 | N | ILE | A | 56 | 8.455 | 105.024 | 39.454 | 1.00 | 27.58 | | N |
| ANISOU | 108 | N | ILE | A | 56 | 3896 | 2620 | 3963 | −64 | −99 | −83 | N |
| ATOM | 109 | CA | ILE | A | 56 | 7.280 | 105.390 | 40.213 | 1.00 | 27.72 | | C |
| ANISOU | 109 | CA | ILE | A | 56 | 3884 | 2594 | 4054 | 15 | −133 | −236 | C |
| ATOM | 110 | C | ILE | A | 56 | 6.479 | 106.490 | 39.521 | 1.00 | 27.91 | | C |
| ANISOU | 110 | C | ILE | A | 56 | 3947 | 2427 | 4231 | 74 | −224 | −210 | C |
| ATOM | 111 | O | ILE | A | 56 | 5.272 | 106.349 | 39.387 | 1.00 | 26.21 | | O |
| ANISOU | 111 | O | ILE | A | 56 | 3707 | 2197 | 4055 | 169 | −257 | −258 | O |
| ATOM | 112 | CB | ILE | A | 56 | 7.685 | 105.754 | 41.652 | 1.00 | 33.83 | | C |
| ANISOU | 112 | CB | ILE | A | 56 | 4618 | 3387 | 4848 | −30 | −117 | −397 | C |
| ATOM | 113 | CG1 | ILE | A | 56 | 8.004 | 104.428 | 42.368 | 1.00 | 33.81 | | C |
| ANISOU | 113 | CG1 | ILE | A | 56 | 4580 | 3585 | 4680 | −53 | −52 | −422 | C |
| ATOM | 114 | CG2 | ILE | A | 56 | 6.573 | 106.470 | 42.372 | 1.00 | 23.36 | | C |
| ANISOU | 114 | CG2 | ILE | A | 56 | 3269 | 1978 | 3630 | 41 | −137 | −574 | C |
| ATOM | 115 | CD1 | ILE | A | 56 | 8.548 | 104.573 | 43.719 | 1.00 | 39.11 | | C |
| ANISOU | 115 | CD1 | ILE | A | 56 | 5234 | 4311 | 5315 | −113 | −50 | −548 | C |
| ATOM | 116 | N | ASP | A | 57 | 7.137 | 107.532 | 39.013 | 1.00 | 24.41 | | N |
| ANISOU | 116 | N | ASP | A | 57 | 3559 | 1832 | 3883 | 16 | −271 | −118 | N |
| ATOM | 117 | CA | ASP | A | 57 | 6.420 | 108.666 | 38.420 | 1.00 | 29.54 | | C |
| ANISOU | 117 | CA | ASP | A | 57 | 4254 | 2269 | 4701 | 72 | −380 | −81 | C |
| ATOM | 118 | C | ASP | A | 57 | 5.695 | 108.431 | 37.076 | 1.00 | 28.91 | | C |
| ANISOU | 118 | C | ASP | A | 57 | 4240 | 2161 | 4584 | 130 | −453 | 77 | C |
| ATOM | 119 | O | ASP | A | 57 | 4.592 | 108.937 | 36.870 | 1.00 | 33.00 | | O |
| ANISOU | 119 | O | ASP | A | 57 | 4750 | 2556 | 5234 | 230 | −557 | 49 | O |
| ATOM | 120 | CB | ASP | A | 57 | 7.379 | 109.840 | 38.225 | 1.00 | 30.15 | | C |
| ANISOU | 120 | CB | ASP | A | 57 | 4385 | 2177 | 4892 | −25 | −413 | −4 | C |
| ATOM | 121 | CG | ASP | A | 57 | 6.675 | 111.073 | 37.724 | 1.00 | 36.34 | | C |
| ANISOU | 121 | CG | ASP | A | 57 | 5221 | 2711 | 5877 | 31 | −541 | 37 | C |
| ATOM | 122 | OD1 | ASP | A | 57 | 5.646 | 111.458 | 38.322 | 1.00 | 42.57 | | O |
| ANISOU | 122 | OD1 | ASP | A | 57 | 5951 | 3418 | 6806 | 139 | −592 | −124 | O |
| ATOM | 123 | OD2 | ASP | A | 57 | 7.138 | 111.648 | 36.721 | 1.00 | 47.51 | | O |
| ANISOU | 123 | OD2 | ASP | A | 57 | 6732 | 4005 | 7314 | −32 | −587 | 233 | O |
| ATOM | 124 | N | GLU | A | 58 | 6.324 | 107.705 | 36.156 | 1.00 | 30.57 | | N |
| ANISOU | 124 | N | GLU | A | 58 | 4514 | 2477 | 4623 | 69 | −406 | 236 | N |
| ATOM | 125 | CA | GLU | A | 58 | 5.832 | 107.611 | 34.771 | 1.00 | 36.12 | | C |
| ANISOU | 125 | CA | GLU | A | 58 | 5317 | 3146 | 5259 | 95 | −485 | 404 | C |
| ATOM | 126 | C | GLU | A | 58 | 5.046 | 106.329 | 34.445 | 1.00 | 33.35 | | C |
| ANISOU | 126 | C | GLU | A | 58 | 4943 | 2954 | 4774 | 164 | −478 | 380 | C |
| ATOM | 127 | O | GLU | A | 58 | 3.984 | 106.385 | 33.828 | 1.00 | 36.01 | | O |
| ANISOU | 127 | O | GLU | A | 58 | 5303 | 3236 | 5143 | 245 | −598 | 412 | O |
| ATOM | 128 | CB | GLU | A | 58 | 7.008 | 107.750 | 33.812 | 1.00 | 41.99 | | C |
| ANISOU | 128 | CB | GLU | A | 58 | 6172 | 3891 | 5893 | −31 | −429 | 595 | C |
| ATOM | 129 | CG | GLU | A | 58 | 7.745 | 109.067 | 33.987 | 1.00 | 57.89 | | C |
| ANISOU | 129 | CG | GLU | A | 58 | 8214 | 5724 | 8057 | −114 | −447 | 643 | C |
| ATOM | 130 | CD | GLU | A | 58 | 8.859 | 109.250 | 32.981 | 1.00 | 70.74 | | C |
| ANISOU | 130 | CD | GLU | A | 58 | 9946 | 7348 | 9585 | −252 | −375 | 843 | C |
| ATOM | 131 | OE1 | GLU | A | 58 | 9.475 | 108.232 | 32.587 | 1.00 | 78.00 | | O |
| ANISOU | 131 | OE1 | GLU | A | 58 | 10865 | 8448 | 10325 | −301 | −252 | 879 | O |
| ATOM | 132 | OE2 | GLU | A | 58 | 9.108 | 110.407 | 32.577 | 1.00 | 70.21 | | O |
| ANISOU | 132 | OE2 | GLU | A | 58 | 9960 | 7090 | 9626 | −315 | −435 | 962 | O |
| ATOM | 133 | N | TYR | A | 59 | 5.575 | 105.186 | 34.848 | 1.00 | 23.34 | | N |
| ANISOU | 133 | N | TYR | A | 59 | 3625 | 1869 | 3373 | 130 | −353 | 328 | N |
| ATOM | 134 | CA | TYR | A | 59 | 4.848 | 103.918 | 34.769 | 1.00 | 27.21 | | C |
| ANISOU | 134 | CA | TYR | A | 59 | 4075 | 2501 | 3763 | 188 | −335 | 275 | C |
| ATOM | 135 | C | TYR | A | 59 | 3.947 | 103.686 | 35.984 | 1.00 | 27.61 | | C |
| ANISOU | 135 | C | TYR | A | 59 | 4000 | 2582 | 3910 | 262 | −327 | 90 | C |
| ATOM | 136 | O | TYR | A | 59 | 2.804 | 103.237 | 35.839 | 1.00 | 25.05 | | O |
| ANISOU | 136 | O | TYR | A | 59 | 3631 | 2277 | 3610 | 339 | −378 | 42 | O |
| ATOM | 137 | CB | TYR | A | 59 | 5.832 | 102.748 | 34.654 | 1.00 | 25.38 | | C |
| ANISOU | 137 | CB | TYR | A | 59 | 3846 | 2435 | 3364 | 121 | −205 | 305 | C |
| ATOM | 138 | CG | TYR | A | 59 | 6.522 | 102.672 | 33.314 | 1.00 | 29.25 | | C |
| ANISOU | 138 | CG | TYR | A | 59 | 4454 | 2935 | 3724 | 55 | −182 | 466 | C |
| ATOM | 139 | CD2 | TYR | A | 59 | 7.758 | 103.274 | 33.112 | 1.00 | 23.50 | | C |
| ANISOU | 139 | CD2 | TYR | A | 59 | 3763 | 2170 | 2994 | −45 | −112 | 553 | C |
| ATOM | 140 | CD1 | TYR | A | 59 | 5.925 | 102.009 | 32.241 | 1.00 | 27.27 | | C |
| ANISOU | 140 | CD1 | TYR | A | 59 | 4278 | 2733 | 3349 | 84 | −224 | 523 | C |
| ATOM | 141 | CE2 | TYR | A | 59 | 8.387 | 103.207 | 31.881 | 1.00 | 32.28 | | C |
| ANISOU | 141 | CE2 | TYR | A | 59 | 4986 | 3303 | 3974 | −118 | −60 | 696 | C |
| ATOM | 142 | CE1 | TYR | A | 59 | 6.543 | 101.943 | 31.008 | 1.00 | 28.01 | | C |
| ANISOU | 142 | CE1 | TYR | A | 59 | 4500 | 2850 | 3293 | 14 | −188 | 659 | C |
| ATOM | 143 | CZ | TYR | A | 59 | 7.773 | 102.538 | 30.833 | 1.00 | 39.37 | | C |
| ANISOU | 143 | CZ | TYR | A | 59 | 5976 | 4260 | 4723 | −88 | −93 | 746 | C |
| ATOM | 144 | OH | TYR | A | 59 | 8.395 | 102.468 | 29.608 | 1.00 | 48.10 | | O |
| ANISOU | 144 | OH | TYR | A | 59 | 7209 | 5399 | 5666 | −170 | −26 | 876 | O |
| ATOM | 145 | N | ALA | A | 60 | 4.486 | 104.006 | 37.166 | 1.00 | 21.48 | | N |
| ANISOU | 145 | N | ALA | A | 60 | 3167 | 1811 | 3182 | 227 | −260 | −15 | N |
| ATOM | 146 | CA | ALA | A | 60 | 3.861 | 103.753 | 38.461 | 1.00 | 21.14 | | C |
| ANISOU | 146 | CA | ALA | A | 60 | 3024 | 1825 | 3183 | 266 | −212 | −196 | C |
| ATOM | 147 | C | ALA | A | 60 | 3.789 | 102.243 | 38.773 | 1.00 | 21.83 | | C |
| ANISOU | 147 | C | ALA | A | 60 | 3071 | 2095 | 3127 | 257 | −126 | −219 | C |
| ATOM | 148 | O | ALA | A | 60 | 3.026 | 101.819 | 39.642 | 1.00 | 23.05 | | O |
| ANISOU | 148 | O | ALA | A | 60 | 3151 | 2312 | 3295 | 288 | −82 | −344 | O |
| ATOM | 149 | CB | ALA | A | 60 | 2.459 | 104.402 | 38.532 | 1.00 | 22.27 | | C |
| ANISOU | 149 | CB | ALA | A | 60 | 3109 | 1855 | 3497 | 369 | −291 | −292 | C |
| ATOM | 150 | N | TYR | A | 61 | 4.597 | 101.456 | 38.065 | 1.00 | 18.98 | | N |
| ANISOU | 150 | N | TYR | A | 61 | 2760 | 1812 | 2639 | 209 | −94 | −100 | N |
| ATOM | 151 | CA | TYR | A | 61 | 4.788 | 100.038 | 38.352 | 1.00 | 24.76 | | C |
| ANISOU | 151 | CA | TYR | A | 61 | 3463 | 2693 | 3253 | 192 | −16 | −109 | C |
| ATOM | 152 | C | TYR | A | 61 | 6.156 | 99.642 | 37.802 | 1.00 | 26.66 | | C |
| ANISOU | 152 | C | TYR | A | 61 | 3747 | 2979 | 3405 | 125 | 31 | 1 | C |
| ATOM | 153 | O | TYR | A | 61 | 6.895 | 100.481 | 37.250 | 1.00 | 21.40 | | O |
| ANISOU | 153 | O | TYR | A | 61 | 3130 | 2238 | 2763 | 82 | 18 | 78 | O |
| ATOM | 154 | CB | TYR | A | 61 | 3.672 | 99.157 | 37.742 | 1.00 | 17.56 | | C |
| ANISOU | 154 | CB | TYR | A | 61 | 2535 | 1820 | 2317 | 249 | −41 | −111 | C |
| ATOM | 155 | CG | TYR | A | 61 | 3.492 | 99.367 | 36.261 | 1.00 | 24.72 | | C |
| ANISOU | 155 | CG | TYR | A | 61 | 3522 | 2667 | 3203 | 268 | −123 | −2 | C |
| ATOM | 156 | CD1 | TYR | A | 61 | 4.350 | 98.768 | 35.335 | 1.00 | 24.58 | | C |
| ANISOU | 156 | CD1 | TYR | A | 61 | 3579 | 2701 | 3058 | 222 | −86 | 101 | C |
| ATOM | 157 | CD2 | TYR | A | 61 | 2.493 | 100.216 | 35.779 | 1.00 | 26.48 | | C |
| ANISOU | 157 | CD2 | TYR | A | 61 | 3751 | 2778 | 3533 | 330 | −241 | −2 | C |
| ATOM | 158 | CE1 | TYR | A | 61 | 4.193 | 98.989 | 33.952 | 1.00 | 26.55 | | C |
| ANISOU | 158 | CE1 | TYR | A | 61 | 3932 | 2908 | 3249 | 225 | −157 | 203 | C |
| ATOM | 159 | CE2 | TYR | A | 61 | 2.331 | 100.440 | 34.416 | 1.00 | 26.67 | | C |
| ANISOU | 159 | CE2 | TYR | A | 61 | 3873 | 2748 | 3514 | 340 | −341 | 116 | C |
| ATOM | 160 | CZ | TYR | A | 61 | 3.181 | 99.833 | 33.505 | 1.00 | 29.81 | | C |
| ANISOU | 160 | CZ | TYR | A | 61 | 4368 | 3213 | 3746 | 280 | −295 | 220 | C |
| ATOM | 161 | OH | TYR | A | 61 | 3.005 | 100.065 | 32.156 | 1.00 | 35.19 | | O |
| ANISOU | 161 | OH | TYR | A | 61 | 5169 | 3853 | 4348 | 277 | −390 | 336 | O |
| ATOM | 162 | N | TYR | A | 62 | 6.503 | 98.376 | 37.999 | 1.00 | 22.02 | | N |
| ANISOU | 162 | N | TYR | A | 62 | 3131 | 2502 | 2731 | 112 | 94 | 3 | N |
| ATOM | 163 | CA | TYR | A | 62 | 7.731 | 97.799 | 37.459 | 1.00 | 22.27 | | C |
| ANISOU | 163 | CA | TYR | A | 62 | 3177 | 2583 | 2700 | 64 | 153 | 85 | C |
| ATOM | 164 | C | TYR | A | 62 | 7.328 | 96.554 | 36.751 | 1.00 | 16.46 | | C |
| ANISOU | 164 | C | TYR | A | 62 | 2455 | 1909 | 1889 | 96 | 177 | 101 | C |
| ATOM | 165 | O | TYR | A | 62 | 6.472 | 95.811 | 37.233 | 1.00 | 16.37 | | O |
| ANISOU | 165 | O | TYR | A | 62 | 2409 | 1937 | 1874 | 132 | 169 | 42 | O |
| ATOM | 166 | CB | TYR | A | 62 | 8.759 | 97.503 | 38.556 | 1.00 | 21.03 | | C |
| ANISOU | 166 | CB | TYR | A | 62 | 2958 | 2483 | 2551 | 18 | 190 | 59 | C |
| ATOM | 167 | CG | TYR | A | 62 | 9.371 | 98.759 | 39.133 | 1.00 | 19.92 | | C |
| ANISOU | 167 | CG | TYR | A | 62 | 2809 | 2277 | 2485 | −31 | 160 | 41 | C |
| ATOM | 168 | CD1 | TYR | A | 62 | 8.638 | 99.587 | 39.971 | 1.00 | 19.71 | | C |
| ANISOU | 168 | CD1 | TYR | A | 62 | 2780 | 2200 | 2510 | −15 | 114 | −54 | C |
| ATOM | 169 | CD2 | TYR | A | 62 | 10.687 | 99.101 | 38.865 | 1.00 | 17.96 | | C |
| ANISOU | 169 | CD2 | TYR | A | 62 | 2543 | 2013 | 2269 | −97 | 186 | 102 | C |
| ATOM | 170 | CE1 | TYR | A | 62 | 9.177 | 100.717 | 40.509 | 1.00 | 19.68 | | C |
| ANISOU | 170 | CE1 | TYR | A | 62 | 2773 | 2125 | 2581 | −62 | 81 | −91 | C |
| ATOM | 171 | CE2 | TYR | A | 62 | 11.247 | 100.242 | 39.407 | 1.00 | 19.64 | | C |
| ANISOU | 171 | CE2 | TYR | A | 62 | 2741 | 2154 | 2565 | −153 | 150 | 78 | C |
| ATOM | 172 | CZ | TYR | A | 62 | 10.486 | 101.052 | 40.229 | 1.00 | 27.84 | | C |
| ANISOU | 172 | CZ | TYR | A | 62 | 3794 | 3136 | 3648 | −135 | 92 | −21 | C |
| ATOM | 173 | OH | TYR | A | 62 | 11.025 | 102.216 | 40.762 | 1.00 | 30.18 | | O |
| ANISOU | 173 | OH | TYR | A | 62 | 4083 | 3347 | 4038 | −193 | 50 | −63 | O |
| ATOM | 174 | N | PHE | A | 63 | 7.906 | 96.324 | 35.589 | 1.00 | 22.73 | | N |
| ANISOU | 174 | N | PHE | A | 63 | 3304 | 2710 | 2623 | 76 | 213 | 175 | N |
| ATOM | 175 | CA | PHE | A | 63 | 7.467 | 95.194 | 34.790 | 1.00 | 23.27 | | C |
| ANISOU | 175 | CA | PHE | A | 63 | 3402 | 2827 | 2615 | 105 | 229 | 172 | C |
| ATOM | 176 | C | PHE | A | 63 | 8.630 | 94.366 | 34.235 | 1.00 | 26.08 | | C |
| ANISOU | 176 | C | PHE | A | 63 | 3756 | 3236 | 2918 | 75 | 332 | 201 | C |
| ATOM | 177 | O | PHE | A | 63 | 9.796 | 94.786 | 34.265 | 1.00 | 25.39 | | O |
| ANISOU | 177 | O | PHE | A | 63 | 3645 | 3147 | 2856 | 26 | 393 | 240 | O |
| ATOM | 178 | CB | PHE | A | 63 | 6.562 | 95.688 | 33.648 | 1.00 | 23.35 | | C |
| ANISOU | 178 | CB | PHE | A | 63 | 3505 | 2787 | 2579 | 128 | 148 | 208 | C |
| ATOM | 179 | CG | PHE | A | 63 | 7.273 | 96.539 | 32.628 | 1.00 | 23.06 | | C |
| ANISOU | 179 | CG | PHE | A | 63 | 3566 | 2711 | 2485 | 77 | 164 | 309 | C |
| ATOM | 180 | CD2 | PHE | A | 63 | 7.746 | 95.981 | 31.455 | 1.00 | 23.93 | | C |
| ANISOU | 180 | CD2 | PHE | A | 63 | 3757 | 2869 | 2466 | 46 | 229 | 352 | C |
| ATOM | 181 | CD1 | PHE | A | 63 | 7.476 | 97.901 | 32.851 | 1.00 | 26.73 | | C |
| ANISOU | 181 | CD1 | PHE | A | 63 | 4047 | 3087 | 3024 | 50 | 124 | 357 | C |
| ATOM | 182 | CE2 | PHE | A | 63 | 8.410 | 96.766 | 30.513 | 1.00 | 33.36 | | C |
| ANISOU | 182 | CE2 | PHE | A | 63 | 5053 | 4036 | 3586 | −20 | 266 | 455 | C |
| ATOM | 183 | CE1 | PHE | A | 63 | 8.132 | 98.689 | 31.919 | 1.00 | 28.17 | | C |
| ANISOU | 183 | CE1 | PHE | A | 63 | 4325 | 3223 | 3155 | −14 | 146 | 469 | C |
| ATOM | 184 | CZ | PHE | A | 63 | 8.593 | 98.126 | 30.748 | 1.00 | 32.14 | | C |
| ANISOU | 184 | CZ | PHE | A | 63 | 4915 | 3787 | 3511 | −53 | 222 | 525 | C |
| ATOM | 185 | N | LEU | A | 64 | 8.297 | 93.170 | 33.755 | 1.00 | 28.77 | | N |
| ANISOU | 185 | N | LEU | A | 64 | 4106 | 3617 | 3207 | 103 | 353 | 168 | N |
| ATOM | 186 | CA | LEU | A | 64 | 9.273 | 92.298 | 33.109 | 1.00 | 30.22 | | C |
| ANISOU | 186 | CA | LEU | A | 64 | 4287 | 3842 | 3352 | 89 | 458 | 168 | C |
| ATOM | 187 | C | LEU | A | 64 | 8.656 | 91.564 | 31.926 | 1.00 | 26.25 | | C |
| ANISOU | 187 | C | LEU | A | 64 | 3871 | 3357 | 2745 | 107 | 458 | 138 | C |
| ATOM | 188 | O | LEU | A | 64 | 7.431 | 91.563 | 31.739 | 1.00 | 25.34 | | O |
| ANISOU | 188 | O | LEU | A | 64 | 3798 | 3225 | 2604 | 135 | 359 | 118 | O |
| ATOM | 189 | CB | LEU | A | 64 | 9.861 | 91.291 | 34.106 | 1.00 | 31.96 | | C |
| ANISOU | 189 | CB | LEU | A | 64 | 4398 | 4087 | 3657 | 106 | 493 | 132 | C |
| ATOM | 190 | CG | LEU | A | 64 | 9.047 | 90.069 | 34.494 | 1.00 | 33.33 | | C |
| ANISOU | 190 | CG | LEU | A | 64 | 4550 | 4267 | 3846 | 148 | 460 | 80 | C |
| ATOM | 191 | CD1 | LEU | A | 64 | 9.946 | 89.074 | 35.173 | 1.00 | 27.60 | | C |
| ANISOU | 191 | CD1 | LEU | A | 64 | 3736 | 3550 | 3200 | 158 | 502 | 75 | C |
| ATOM | 192 | CD2 | LEU | A | 64 | 7.956 | 90.485 | 35.435 | 1.00 | 38.42 | | C |
| ANISOU | 192 | CD2 | LEU | A | 64 | 5181 | 4901 | 4514 | 155 | 375 | 67 | C |
| ATOM | 193 | N | ASP | A | 65 | 9.514 | 90.960 | 31.115 | 1.00 | 21.85 | | N |
| ANISOU | 193 | N | ASP | A | 65 | 3335 | 2834 | 2134 | 90 | 570 | 124 | N |
| ATOM | 194 | CA | ASP | A | 65 | 9.045 | 90.191 | 29.967 | 1.00 | 25.69 | | C |
| ANISOU | 194 | CA | ASP | A | 65 | 3915 | 3343 | 2502 | 99 | 581 | 74 | C |
| ATOM | 195 | C | ASP | A | 65 | 9.078 | 88.698 | 30.239 | 1.00 | 30.22 | | C |
| ANISOU | 195 | C | ASP | A | 65 | 4421 | 3923 | 3140 | 141 | 617 | −18 | C |
| ATOM | 196 | O | ASP | A | 65 | 10.002 | 88.186 | 30.885 | 1.00 | 31.46 | | O |
| ANISOU | 196 | O | ASP | A | 65 | 4471 | 4076 | 3404 | 152 | 690 | −30 | O |
| ATOM | 197 | CB | ASP | A | 65 | 9.883 | 90.482 | 28.733 | 1.00 | 31.89 | | C |
| ANISOU | 197 | CB | ASP | A | 65 | 4794 | 4164 | 3157 | 45 | 699 | 98 | C |
| ATOM | 198 | CG | ASP | A | 65 | 9.770 | 91.912 | 28.273 | 1.00 | 41.39 | | C |
| ANISOU | 198 | CG | ASP | A | 65 | 6098 | 5346 | 4281 | −7 | 653 | 208 | C |
| ATOM | 199 | OD1 | ASP | A | 65 | 8.691 | 92.523 | 28.438 | 1.00 | 44.55 | | O |
| ANISOU | 199 | OD1 | ASP | A | 65 | 6539 | 5703 | 4684 | 15 | 499 | 243 | O |
| ATOM | 200 | OD2 | ASP | A | 65 | 10.765 | 92.417 | 27.719 | 1.00 | 49.74 | | O |
| ANISOU | 200 | OD2 | ASP | A | 65 | 7189 | 6424 | 5285 | −73 | 776 | 260 | O |
| ATOM | 201 | N | ILE | A | 66 | 8.072 | 88.010 | 29.707 | 1.00 | 34.56 | | N |
| ANISOU | 201 | N | ILE | A | 66 | 5031 | 4468 | 3633 | 161 | 550 | −79 | N |
| ATOM | 202 | CA | ILE | A | 66 | 7.948 | 86.559 | 29.797 | 1.00 | 31.40 | | C |
| ANISOU | 202 | CA | ILE | A | 66 | 4586 | 4050 | 3292 | 193 | 571 | −172 | C |
| ATOM | 203 | C | ILE | A | 66 | 7.477 | 85.993 | 28.455 | 1.00 | 33.36 | | C |
| ANISOU | 203 | C | ILE | A | 66 | 4955 | 4315 | 3405 | 186 | 566 | −255 | C |
| ATOM | 204 | O | ILE | A | 66 | 6.851 | 86.701 | 27.651 | 1.00 | 36.20 | | O |
| ANISOU | 204 | O | ILE | A | 66 | 5430 | 4697 | 3626 | 161 | 489 | −228 | O |
| ATOM | 205 | CB | ILE | A | 66 | 7.000 | 86.183 | 30.952 | 1.00 | 32.34 | | C |
| ANISOU | 205 | CB | ILE | A | 66 | 4626 | 4132 | 3529 | 216 | 471 | −171 | C |
| ATOM | 206 | CG1 | ILE | A | 66 | 7.757 | 86.338 | 32.264 | 1.00 | 40.73 | | C |
| ANISOU | 206 | CG1 | ILE | A | 66 | 5580 | 5187 | 4708 | 220 | 503 | −114 | C |
| ATOM | 207 | CG2 | ILE | A | 66 | 6.507 | 84.774 | 30.853 | 1.00 | 31.20 | | C |
| ANISOU | 207 | CG2 | ILE | A | 66 | 4467 | 3952 | 3435 | 235 | 459 | −256 | C |
| ATOM | 208 | CD1 | ILE | A | 66 | 7.131 | 85.616 | 33.417 | 1.00 | 47.95 | | C |
| ANISOU | 208 | CD1 | ILE | A | 66 | 6423 | 6071 | 5724 | 231 | 451 | −116 | C |
| ATOM | 209 | N | ASP | A | 67 | 7.863 | 84.752 | 28.166 | 1.00 | 27.32 | | N |
| ANISOU | 209 | N | ASP | A | 67 | 4172 | 3534 | 2674 | 205 | 644 | −357 | N |
| ATOM | 210 | CA | ASP | A | 67 | 7.434 | 84.085 | 26.946 | 1.00 | 29.35 | | C |
| ANISOU | 210 | CA | ASP | A | 67 | 4545 | 3804 | 2803 | 195 | 640 | −466 | C |
| ATOM | 211 | C | ASP | A | 67 | 6.250 | 83.191 | 27.209 | 1.00 | 29.42 | | C |
| ANISOU | 211 | C | ASP | A | 67 | 4531 | 3758 | 2889 | 213 | 514 | −532 | C |
| ATOM | 212 | O | ASP | A | 67 | 6.196 | 82.480 | 28.214 | 1.00 | 29.30 | | O |
| ANISOU | 212 | O | ASP | A | 67 | 4402 | 3684 | 3049 | 239 | 509 | −534 | O |
| ATOM | 213 | CB | ASP | A | 67 | 8.573 | 83.284 | 26.344 | 1.00 | 38.52 | | C |
| ANISOU | 213 | CB | ASP | A | 67 | 5704 | 4972 | 3959 | 203 | 816 | −569 | C |
| ATOM | 214 | CG | ASP | A | 67 | 9.702 | 84.162 | 25.899 | 1.00 | 45.51 | | C |
| ANISOU | 214 | CG | ASP | A | 67 | 6614 | 5922 | 4757 | 167 | 960 | −516 | C |
| ATOM | 215 | OD1 | ASP | A | 67 | 9.425 | 85.128 | 25.156 | 1.00 | 40.50 | | O |
| ANISOU | 215 | OD1 | ASP | A | 67 | 6113 | 5343 | 3934 | 114 | 931 | −453 | O |
| ATOM | 216 | OD2 | ASP | A | 67 | 10.851 | 83.907 | 26.320 | 1.00 | 55.43 | | O |
| ANISOU | 216 | OD2 | ASP | A | 67 | 7750 | 7166 | 6146 | 188 | 1093 | −527 | O |
| ATOM | 217 | N | ILE | A | 68 | 5.281 | 83.253 | 26.310 | 1.00 | 27.91 | | N |
| ANISOU | 217 | N | ILE | A | 68 | 4451 | 3586 | 2567 | 190 | 403 | −576 | N |
| ATOM | 218 | CA | ILE | A | 68 | 4.065 | 82.477 | 26.452 | 1.00 | 27.55 | | C |
| ANISOU | 218 | CA | ILE | A | 68 | 4377 | 3489 | 2601 | 194 | 271 | −644 | C |
| ATOM | 219 | C | ILE | A | 68 | 3.655 | 81.882 | 25.109 | 1.00 | 28.79 | | C |
| ANISOU | 219 | C | ILE | A | 68 | 4670 | 3662 | 2607 | 168 | 223 | −774 | C |
| ATOM | 220 | O | ILE | A | 68 | 3.706 | 82.551 | 24.081 | 1.00 | 33.75 | | O |
| ANISOU | 220 | O | ILE | A | 68 | 5442 | 4357 | 3023 | 139 | 202 | −763 | O |
| ATOM | 221 | CB | ILE | A | 68 | 2.940 | 83.331 | 27.043 | 1.00 | 32.71 | | C |
| ANISOU | 221 | CB | ILE | A | 68 | 4983 | 4140 | 3306 | 192 | 119 | −557 | C |
| ATOM | 222 | CG1 | ILE | A | 68 | 3.347 | 83.785 | 28.459 | 1.00 | 30.33 | | C |
| ANISOU | 222 | CG1 | ILE | A | 68 | 4553 | 3824 | 3147 | 211 | 178 | −458 | C |
| ATOM | 223 | CG2 | ILE | A | 68 | 1.638 | 82.550 | 27.062 | 1.00 | 29.34 | | C |
| ANISOU | 223 | CG2 | ILE | A | 68 | 4515 | 3667 | 2967 | 183 | −13 | −637 | C |
| ATOM | 224 | CD1 | ILE | A | 68 | 2.330 | 84.551 | 29.198 | 1.00 | 22.78 | | C |
| ANISOU | 224 | CD1 | ILE | A | 68 | 3528 | 2860 | 2266 | 214 | 69 | −398 | C |
| ATOM | 225 | N | GLY | A | 69 | 3.316 | 80.597 | 25.114 | 1.00 | 29.37 | | N |
| ANISOU | 225 | N | GLY | A | 69 | 4710 | 3669 | 2783 | 173 | 211 | −899 | N |
| ATOM | 226 | CA | GLY | A | 69 | 2.842 | 79.938 | 23.912 | 1.00 | 25.81 | | C |
| ANISOU | 226 | CA | GLY | A | 69 | 4382 | 3222 | 2201 | 144 | 148 | −1048 | C |
| ATOM | 227 | C | GLY | A | 69 | 3.936 | 79.281 | 23.095 | 1.00 | 33.17 | | C |
| ANISOU | 227 | C | GLY | A | 69 | 5399 | 4169 | 3036 | 146 | 321 | −1178 | C |
| ATOM | 228 | O | GLY | A | 69 | 5.099 | 79.266 | 23.492 | 1.00 | 33.93 | | O |
| ANISOU | 228 | O | GLY | A | 69 | 5432 | 4262 | 3200 | 177 | 494 | −1152 | O |
| ATOM | 229 | N | THR | A | 70 | 3.543 | 78.726 | 21.951 | 1.00 | 31.18 | | N |
| ANISOU | 229 | N | THR | A | 70 | 5284 | 3931 | 2631 | 113 | 271 | −1332 | N |
| ATOM | 230 | CA | THR | A | 70 | 4.435 | 78.011 | 21.066 | 1.00 | 30.94 | | C |
| ANISOU | 230 | CA | THR | A | 70 | 5346 | 3915 | 2495 | 110 | 439 | −1501 | C |
| ATOM | 231 | C | THR | A | 70 | 4.025 | 78.332 | 19.636 | 1.00 | 46.21 | | C |
| ANISOU | 231 | C | THR | A | 70 | 7507 | 5950 | 4102 | 45 | 363 | −1578 | C |
| ATOM | 232 | O | THR | A | 70 | 2.967 | 77.902 | 19.187 | 1.00 | 49.15 | | O |
| ANISOU | 232 | O | THR | A | 70 | 7941 | 6300 | 4434 | 15 | 177 | −1667 | O |
| ATOM | 233 | CB | THR | A | 70 | 4.376 | 76.479 | 21.302 | 1.00 | 46.80 | | C |
| ANISOU | 233 | CB | THR | A | 70 | 7273 | 5789 | 4719 | 139 | 463 | −1673 | C |
| ATOM | 234 | OG1 | THR | A | 70 | 4.586 | 76.193 | 22.691 | 1.00 | 42.92 | | O |
| ANISOU | 234 | OG1 | THR | A | 70 | 6589 | 5199 | 4521 | 189 | 488 | −1569 | O |
| ATOM | 235 | CG2 | THR | A | 70 | 5.419 | 75.740 | 20.448 | 1.00 | 33.54 | | C |
| ANISOU | 235 | CG2 | THR | A | 70 | 5667 | 4111 | 2966 | 152 | 667 | −1871 | C |
| ATOM | 236 | N | PRO | A | 71 | 4.844 | 79.109 | 18.914 | 1.00 | 44.08 | | N |
| ANISOU | 236 | N | PRO | A | 71 | 7319 | 5801 | 3629 | 19 | 483 | −1515 | N |
| ATOM | 237 | CA | PRO | A | 71 | 6.126 | 79.673 | 19.347 | 1.00 | 41.29 | | C |
| ANISOU | 237 | CA | PRO | A | 71 | 6883 | 5478 | 3326 | 42 | 697 | −1413 | C |
| ATOM | 238 | C | PRO | A | 71 | 5.956 | 80.797 | 20.371 | 1.00 | 38.92 | | C |
| ANISOU | 238 | C | PRO | A | 71 | 6525 | 5164 | 3098 | 51 | 635 | −1204 | C |
| ATOM | 239 | O | PRO | A | 71 | 4.860 | 81.303 | 20.574 | 1.00 | 44.12 | | O |
| ANISOU | 239 | O | PRO | A | 71 | 7194 | 5813 | 3757 | 43 | 419 | −1113 | O |
| ATOM | 240 | CB | PRO | A | 71 | 6.726 | 80.196 | 18.044 | 1.00 | 41.97 | | C |
| ANISOU | 240 | CB | PRO | A | 71 | 7078 | 5704 | 3163 | −9 | 780 | −1397 | C |
| ATOM | 241 | CG | PRO | A | 71 | 5.541 | 80.528 | 17.199 | 1.00 | 38.07 | | C |
| ANISOU | 241 | CG | PRO | A | 71 | 6743 | 5263 | 2458 | −65 | 551 | −1381 | C |
| ATOM | 242 | CD | PRO | A | 71 | 4.484 | 79.530 | 17.547 | 1.00 | 36.29 | | C |
| ANISOU | 242 | CD | PRO | A | 71 | 6489 | 4937 | 2364 | −43 | 389 | −1516 | C |
| ATOM | 243 | N | GLU | A | 72 | 7.041 | 81.162 | 21.029 | 1.00 | 33.88 | | N |
| ANISOU | 243 | N | GLU | A | 72 | 5771 | 4525 | 2576 | 76 | 803 | −1123 | N |
| ATOM | 244 | CA | GLU | A | 72 | 6.964 | 82.077 | 22.143 | 1.00 | 33.32 | | C |
| ANISOU | 244 | CA | GLU | A | 72 | 5579 | 4433 | 2648 | 97 | 737 | −933 | C |
| ATOM | 245 | C | GLU | A | 72 | 6.425 | 83.440 | 21.742 | 1.00 | 31.15 | | C |
| ANISOU | 245 | C | GLU | A | 72 | 5426 | 4220 | 2190 | 48 | 611 | −782 | C |
| ATOM | 246 | O | GLU | A | 72 | 6.746 | 83.960 | 20.684 | 1.00 | 33.78 | | O |
| ANISOU | 246 | O | GLU | A | 72 | 5927 | 4633 | 2273 | −11 | 666 | −768 | O |
| ATOM | 247 | CB | GLU | A | 72 | 8.338 | 82.226 | 22.794 | 1.00 | 43.38 | | C |
| ANISOU | 247 | CB | GLU | A | 72 | 6719 | 5703 | 4062 | 122 | 936 | −889 | C |
| ATOM | 248 | CG | GLU | A | 72 | 8.853 | 80.942 | 23.436 | 1.00 | 53.37 | | C |
| ANISOU | 248 | CG | GLU | A | 72 | 7829 | 6877 | 5571 | 188 | 1021 | −1001 | C |
| ATOM | 249 | CD | GLU | A | 72 | 10.217 | 81.113 | 24.092 | 1.00 | 63.06 | | C |
| ANISOU | 249 | CD | GLU | A | 72 | 8907 | 8097 | 6957 | 218 | 1186 | −951 | C |
| ATOM | 250 | OE1 | GLU | A | 72 | 10.963 | 82.043 | 23.708 | 1.00 | 62.54 | | O |
| ANISOU | 250 | OE1 | GLU | A | 72 | 8874 | 8110 | 6779 | 175 | 1301 | −886 | O |
| ATOM | 251 | OE2 | GLU | A | 72 | 10.534 | 80.320 | 25.007 | 1.00 | 66.79 | | O |
| ANISOU | 251 | OE2 | GLU | A | 72 | 9225 | 8477 | 7673 | 280 | 1190 | −969 | O |
| ATOM | 252 | N | GLN | A | 73 | 5.576 | 84.004 | 22.585 | 1.00 | 29.48 | | N |
| ANISOU | 252 | N | GLN | A | 73 | 5132 | 3964 | 2103 | 72 | 441 | −671 | N |
| ATOM | 253 | CA | GLN | A | 73 | 5.175 | 85.400 | 22.429 | 1.00 | 32.70 | | C |
| ANISOU | 253 | CA | GLN | A | 73 | 5616 | 4399 | 2408 | 45 | 325 | −512 | C |
| ATOM | 254 | C | GLN | A | 73 | 5.638 | 86.193 | 23.637 | 1.00 | 37.37 | | C |
| ANISOU | 254 | C | GLN | A | 73 | 6062 | 4956 | 3179 | 70 | 369 | −385 | C |
| ATOM | 255 | O | GLN | A | 73 | 5.265 | 85.897 | 24.775 | 1.00 | 40.51 | | O |
| ANISOU | 255 | O | GLN | A | 73 | 6306 | 5299 | 3788 | 115 | 323 | −387 | O |
| ATOM | 256 | CB | GLN | A | 73 | 3.656 | 85.527 | 22.249 | 1.00 | 26.63 | | C |
| ANISOU | 256 | CB | GLN | A | 73 | 4883 | 3604 | 1630 | 53 | 63 | −506 | C |
| ATOM | 257 | CG | GLN | A | 73 | 3.122 | 84.835 | 20.997 | 1.00 | 33.74 | | C |
| ANISOU | 257 | CG | GLN | A | 73 | 5947 | 4541 | 2332 | 17 | −23 | −630 | C |
| ATOM | 258 | CD | GLN | A | 73 | 1.639 | 85.072 | 20.768 | 1.00 | 43.86 | | C |
| ANISOU | 258 | CD | GLN | A | 73 | 7251 | 5797 | 3616 | 22 | −309 | −613 | C |
| ATOM | 259 | OE1 | GLN | A | 73 | 1.144 | 86.207 | 20.843 | 1.00 | 50.28 | | O |
| ANISOU | 259 | OE1 | GLN | A | 73 | 8078 | 6599 | 4426 | 29 | −450 | −471 | O |
| ATOM | 260 | NE2 | GLN | A | 73 | 0.916 | 83.994 | 20.489 | 1.00 | 43.89 | | N |
| ANISOU | 260 | NE2 | GLN | A | 73 | 7247 | 5779 | 3650 | 20 | −403 | −764 | N |
| ATOM | 261 | N | ARG | A | 74 | 6.464 | 87.200 | 23.391 | 1.00 | 40.21 | | N |
| ANISOU | 261 | N | ARG | A | 74 | 6478 | 5352 | 3448 | 29 | 462 | −278 | N |
| ATOM | 262 | CA | ARG | A | 74 | 6.974 | 88.047 | 24.466 | 1.00 | 39.33 | | C |
| ANISOU | 262 | CA | ARG | A | 74 | 6242 | 5207 | 3495 | 41 | 499 | −167 | C |
| ATOM | 263 | C | ARG | A | 74 | 5.838 | 88.876 | 25.022 | 1.00 | 35.08 | | C |
| ANISOU | 263 | C | ARG | A | 74 | 5678 | 4618 | 3034 | 68 | 295 | −82 | C |
| ATOM | 264 | O | ARG | A | 74 | 5.080 | 89.486 | 24.270 | 1.00 | 40.24 | | O |
| ANISOU | 264 | O | ARG | A | 74 | 6457 | 5270 | 3563 | 51 | 151 | −29 | O |
| ATOM | 265 | CB | ARG | A | 74 | 8.083 | 88.964 | 23.944 | 1.00 | 46.22 | | C |
| ANISOU | 265 | CB | ARG | A | 74 | 7187 | 6120 | 4253 | −25 | 642 | −74 | C |
| ATOM | 266 | CG | ARG | A | 74 | 8.801 | 89.852 | 24.960 | 1.00 | 50.79 | | C |
| ANISOU | 266 | CG | ARG | A | 74 | 7642 | 6665 | 4992 | −29 | 693 | 28 | C |
| ATOM | 267 | CD | ARG | A | 74 | 10.063 | 90.438 | 24.305 | 1.00 | 59.21 | | C |
| ANISOU | 267 | CD | ARG | A | 74 | 8763 | 7777 | 5957 | −110 | 882 | 86 | C |
| ATOM | 268 | NE | ARG | A | 74 | 10.667 | 91.546 | 25.045 | 1.00 | 69.75 | | N |
| ANISOU | 268 | NE | ARG | A | 74 | 10016 | 9071 | 7415 | −138 | 902 | 201 | N |
| ATOM | 269 | CZ | ARG | A | 74 | 10.506 | 92.834 | 24.731 | 1.00 | 79.56 | | C |
| ANISOU | 269 | CZ | ARG | A | 74 | 11362 | 10281 | 8585 | −194 | 836 | 340 | C |
| ATOM | 270 | NH1 | ARG | A | 74 | 9.758 | 93.183 | 23.691 | 1.00 | 84.98 | | N |
| ANISOU | 270 | NH1 | ARG | A | 74 | 12243 | 10976 | 9070 | −224 | 734 | 398 | N |
| ATOM | 271 | NH2 | ARG | A | 74 | 11.093 | 93.780 | 25.455 | 1.00 | 77.94 | | N |
| ANISOU | 271 | NH2 | ARG | A | 74 | 11071 | 10026 | 8516 | −222 | 856 | 425 | N |
| ATOM | 272 | N | ILE | A | 75 | 5.683 | 88.862 | 26.339 | 1.00 | 32.91 | | N |
| ANISOU | 272 | N | ILE | A | 75 | 5240 | 4297 | 2966 | 111 | 277 | −77 | N |
| ATOM | 273 | CA | ILE | A | 75 | 4.631 | 89.654 | 26.964 | 1.00 | 34.71 | | C |
| ANISOU | 273 | CA | ILE | A | 75 | 5421 | 4475 | 3291 | 140 | 114 | −22 | C |
| ATOM | 274 | C | ILE | A | 75 | 5.172 | 90.356 | 28.209 | 1.00 | 31.61 | | C |
| ANISOU | 274 | C | ILE | A | 75 | 4910 | 4054 | 3046 | 149 | 169 | 36 | C |
| ATOM | 275 | O | ILE | A | 75 | 5.856 | 89.755 | 29.033 | 1.00 | 30.03 | | O |
| ANISOU | 275 | O | ILE | A | 75 | 4607 | 3863 | 2941 | 156 | 274 | 2 | O |
| ATOM | 276 | CB | ILE | A | 75 | 3.397 | 88.795 | 27.303 | 1.00 | 34.95 | | C |
| ANISOU | 276 | CB | ILE | A | 75 | 5378 | 4483 | 3419 | 179 | −1 | −112 | C |
| ATOM | 277 | CG1 | ILE | A | 75 | 2.599 | 88.523 | 26.033 | 1.00 | 43.14 | | C |
| ANISOU | 277 | CG1 | ILE | A | 75 | 6544 | 5536 | 4312 | 166 | −130 | −152 | C |
| ATOM | 278 | CG2 | ILE | A | 75 | 2.477 | 89.519 | 28.206 | 1.00 | 38.32 | | C |
| ANISOU | 278 | CG2 | ILE | A | 75 | 5705 | 4863 | 3993 | 213 | −113 | −79 | C |
| ATOM | 279 | CD1 | ILE | A | 75 | 2.070 | 87.129 | 25.942 | 1.00 | 46.89 | | C |
| ANISOU | 279 | CD1 | ILE | A | 75 | 6981 | 6009 | 4826 | 173 | −148 | −284 | C |
| ATOM | 280 | N | SER | A | 76 | 4.908 | 91.657 | 28.286 | 1.00 | 29.22 | | N |
| ANISOU | 280 | N | SER | A | 76 | 4635 | 3711 | 2758 | 145 | 87 | 125 | N |
| ATOM | 281 | CA | SER | A | 76 | 5.271 | 92.476 | 29.435 | 1.00 | 27.31 | | C |
| ANISOU | 281 | CA | SER | A | 76 | 4296 | 3432 | 2650 | 150 | 112 | 165 | C |
| ATOM | 282 | C | SER | A | 76 | 4.186 | 92.417 | 30.509 | 1.00 | 24.93 | | C |
| ANISOU | 282 | C | SER | A | 76 | 3877 | 3098 | 2496 | 200 | 23 | 109 | C |
| ATOM | 283 | O | SER | A | 76 | 2.993 | 92.555 | 30.213 | 1.00 | 25.17 | | O |
| ANISOU | 283 | O | SER | A | 76 | 3916 | 3099 | 2547 | 233 | −110 | 91 | O |
| ATOM | 284 | CB | SER | A | 76 | 5.495 | 93.914 | 29.002 | 1.00 | 25.36 | | C |
| ANISOU | 284 | CB | SER | A | 76 | 4134 | 3134 | 2367 | 119 | 69 | 276 | C |
| ATOM | 285 | OG | SER | A | 76 | 4.375 | 94.346 | 28.258 | 1.00 | 34.57 | | O |
| ANISOU | 285 | OG | SER | A | 76 | 5386 | 4260 | 3487 | 142 | −98 | 308 | O |
| ATOM | 286 | N | LEU | A | 77 | 4.615 | 92.219 | 31.751 | 1.00 | 21.09 | | N |
| ANISOU | 286 | N | LEU | A | 77 | 3282 | 2620 | 2110 | 202 | 98 | 82 | N |
| ATOM | 287 | CA | LEU | A | 77 | 3.718 | 92.005 | 32.862 | 1.00 | 16.08 | | C |
| ANISOU | 287 | CA | LEU | A | 77 | 2542 | 1977 | 1592 | 232 | 61 | 21 | C |
| ATOM | 288 | C | LEU | A | 77 | 4.110 | 92.850 | 34.065 | 1.00 | 27.87 | | C |
| ANISOU | 288 | C | LEU | A | 77 | 3971 | 3453 | 3164 | 224 | 92 | 30 | C |
| ATOM | 289 | O | LEU | A | 77 | 5.283 | 92.904 | 34.442 | 1.00 | 26.38 | | O |
| ANISOU | 289 | O | LEU | A | 77 | 3775 | 3284 | 2966 | 192 | 170 | 60 | O |
| ATOM | 290 | CB | LEU | A | 77 | 3.741 | 90.528 | 33.267 | 1.00 | 15.56 | | C |
| ANISOU | 290 | CB | LEU | A | 77 | 2421 | 1950 | 1541 | 229 | 122 | −35 | C |
| ATOM | 291 | CG | LEU | A | 77 | 3.469 | 89.540 | 32.139 | 1.00 | 22.18 | | C |
| ANISOU | 291 | CG | LEU | A | 77 | 3320 | 2800 | 2308 | 231 | 103 | −71 | C |
| ATOM | 292 | CD1 | LEU | A | 77 | 3.818 | 88.113 | 32.572 | 1.00 | 21.47 | | C |
| ANISOU | 292 | CD1 | LEU | A | 77 | 3179 | 2724 | 2257 | 226 | 180 | −116 | C |
| ATOM | 293 | CD2 | LEU | A | 77 | 2.008 | 89.654 | 31.729 | 1.00 | 22.60 | | C |
| ANISOU | 293 | CD2 | LEU | A | 77 | 3371 | 2829 | 2388 | 254 | −31 | −108 | C |
| ATOM | 294 | N | ILE | A | 78 | 3.120 | 93.476 | 34.688 | 1.00 | 22.89 | | N |
| ANISOU | 294 | N | ILE | A | 78 | 3287 | 2788 | 2624 | 252 | 29 | −12 | N |
| ATOM | 295 | CA | ILE | A | 78 | 3.339 | 94.187 | 35.934 | 1.00 | 26.79 | | C |
| ANISOU | 295 | CA | ILE | A | 78 | 3722 | 3270 | 3185 | 243 | 62 | −39 | C |
| ATOM | 296 | C | ILE | A | 78 | 3.697 | 93.203 | 37.043 | 1.00 | 27.63 | | C |
| ANISOU | 296 | C | ILE | A | 78 | 3770 | 3444 | 3283 | 216 | 145 | −71 | C |
| ATOM | 297 | O | ILE | A | 78 | 2.966 | 92.246 | 37.286 | 1.00 | 25.96 | | O |
| ANISOU | 297 | O | ILE | A | 78 | 3517 | 3262 | 3083 | 221 | 156 | −110 | O |
| ATOM | 298 | CB | ILE | A | 78 | 2.093 | 95.000 | 36.339 | 1.00 | 19.00 | | C |
| ANISOU | 298 | CB | ILE | A | 78 | 2680 | 2231 | 2309 | 287 | −7 | −105 | C |
| ATOM | 299 | CG1 | ILE | A | 78 | 1.774 | 96.023 | 35.247 | 1.00 | 21.73 | | C |
| ANISOU | 299 | CG1 | ILE | A | 78 | 3090 | 2488 | 2678 | 319 | −120 | −51 | C |
| ATOM | 300 | CG2 | ILE | A | 78 | 2.317 | 95.688 | 37.688 | 1.00 | 16.31 | | C |
| ANISOU | 300 | CG2 | ILE | A | 78 | 2289 | 1887 | 2023 | 272 | 44 | −163 | C |
| ATOM | 301 | CD1 | ILE | A | 78 | 0.596 | 96.941 | 35.586 | 1.00 | 25.31 | | C |
| ANISOU | 301 | CD1 | ILE | A | 78 | 3473 | 2860 | 3283 | 379 | −205 | −119 | C |
| ATOM | 302 | N | LEU | A | 79 | 4.810 | 93.450 | 37.730 | 1.00 | 22.67 | | N |
| ANISOU | 302 | N | LEU | A | 79 | 3138 | 2834 | 2642 | 180 | 191 | −46 | N |
| ATOM | 303 | CA | LEU | A | 79 | 5.273 | 92.528 | 38.749 | 1.00 | 20.14 | | C |
| ANISOU | 303 | CA | LEU | A | 79 | 2779 | 2571 | 2303 | 153 | 242 | −51 | C |
| ATOM | 304 | C | LEU | A | 79 | 4.501 | 92.817 | 40.017 | 1.00 | 28.18 | | C |
| ANISOU | 304 | C | LEU | A | 79 | 3756 | 3608 | 3341 | 142 | 250 | −120 | C |
| ATOM | 305 | O | LEU | A | 79 | 4.667 | 93.887 | 40.624 | 1.00 | 27.90 | | O |
| ANISOU | 305 | O | LEU | A | 79 | 3720 | 3556 | 3324 | 130 | 241 | −155 | O |
| ATOM | 306 | CB | LEU | A | 79 | 6.774 | 92.664 | 38.957 | 1.00 | 20.69 | | C |
| ANISOU | 306 | CB | LEU | A | 79 | 2849 | 2651 | 2360 | 119 | 266 | 1 | C |
| ATOM | 307 | CG | LEU | A | 79 | 7.348 | 91.631 | 39.928 | 1.00 | 26.64 | | C |
| ANISOU | 307 | CG | LEU | A | 79 | 3567 | 3454 | 3102 | 97 | 286 | 18 | C |
| ATOM | 308 | CD1 | LEU | A | 79 | 7.373 | 90.236 | 39.308 | 1.00 | 21.28 | | C |
| ANISOU | 308 | CD1 | LEU | A | 79 | 2885 | 2779 | 2423 | 119 | 312 | 42 | C |
| ATOM | 309 | CD2 | LEU | A | 79 | 8.715 | 92.043 | 40.428 | 1.00 | 24.60 | | C |
| ANISOU | 309 | CD2 | LEU | A | 79 | 3284 | 3204 | 2858 | 64 | 277 | 53 | C |
| ATOM | 310 | N | ASP | A | 80 | 3.629 | 91.887 | 40.410 | 1.00 | 22.32 | | N |
| ANISOU | 310 | N | ASP | A | 80 | 2982 | 2899 | 2599 | 139 | 277 | −150 | N |
| ATOM | 311 | CA | ASP | A | 80 | 2.643 | 92.182 | 41.458 | 1.00 | 15.93 | | C |
| ANISOU | 311 | CA | ASP | A | 80 | 2129 | 2114 | 1810 | 125 | 311 | −232 | C |
| ATOM | 312 | C | ASP | A | 80 | 2.545 | 91.149 | 42.573 | 1.00 | 18.71 | | C |
| ANISOU | 312 | C | ASP | A | 80 | 2472 | 2532 | 2104 | 69 | 374 | −224 | C |
| ATOM | 313 | O | ASP | A | 80 | 1.800 | 90.166 | 42.477 | 1.00 | 19.60 | | O |
| ANISOU | 313 | O | ASP | A | 80 | 2557 | 2654 | 2237 | 59 | 400 | −221 | O |
| ATOM | 314 | CB | ASP | A | 80 | 1.261 | 92.357 | 40.827 | 1.00 | 15.23 | | C |
| ANISOU | 314 | CB | ASP | A | 80 | 1989 | 1988 | 1810 | 169 | 287 | −294 | C |
| ATOM | 315 | CG | ASP | A | 80 | 0.207 | 92.674 | 41.841 | 1.00 | 31.05 | | C |
| ANISOU | 315 | CG | ASP | A | 80 | 3922 | 4015 | 3861 | 159 | 347 | −399 | C |
| ATOM | 316 | OD1 | ASP | A | 80 | 0.552 | 93.213 | 42.906 | 1.00 | 28.96 | | O |
| ANISOU | 316 | OD1 | ASP | A | 80 | 3671 | 3783 | 3551 | 127 | 395 | −440 | O |
| ATOM | 317 | OD2 | ASP | A | 80 | −0.975 | 92.368 | 41.593 | 1.00 | 37.83 | | O |
| ANISOU | 317 | OD2 | ASP | A | 80 | 4707 | 4865 | 4803 | 177 | 350 | −451 | O |
| ATOM | 318 | N | THR | A | 81 | 3.220 | 91.411 | 43.680 | 1.00 | 21.58 | | N |
| ANISOU | 318 | N | THR | A | 81 | 2864 | 2940 | 2395 | 24 | 390 | −220 | N |
| ATOM | 319 | CA | THR | A | 81 | 3.188 | 90.460 | 44.772 | 1.00 | 25.99 | | C |
| ANISOU | 319 | CA | THR | A | 81 | 3441 | 3563 | 2872 | −40 | 436 | −187 | C |
| ATOM | 320 | C | THR | A | 81 | 1.867 | 90.556 | 45.547 | 1.00 | 26.70 | | C |
| ANISOU | 320 | C | THR | A | 81 | 3497 | 3695 | 2954 | −73 | 527 | −279 | C |
| ATOM | 321 | O | THR | A | 81 | 1.681 | 89.870 | 46.540 | 1.00 | 27.91 | | O |
| ANISOU | 321 | O | THR | A | 81 | 3676 | 3908 | 3019 | −144 | 586 | −255 | O |
| ATOM | 322 | CB | THR | A | 81 | 4.399 | 90.655 | 45.715 | 1.00 | 22.71 | | C |
| ANISOU | 322 | CB | THR | A | 81 | 3079 | 3187 | 2362 | −84 | 399 | −142 | C |
| ATOM | 323 | OG1 | THR | A | 81 | 4.353 | 91.953 | 46.313 | 1.00 | 21.29 | | O |
| ANISOU | 323 | OG1 | THR | A | 81 | 2909 | 3022 | 2158 | −96 | 406 | −241 | O |
| ATOM | 324 | CG2 | THR | A | 81 | 5.710 | 90.481 | 44.934 | 1.00 | 17.05 | | C |
| ANISOU | 324 | CG2 | THR | A | 81 | 2362 | 2428 | 1687 | −52 | 326 | −57 | C |
| ATOM | 325 | N | GLY | A | 82 | 0.950 | 91.399 | 45.076 | 1.00 | 28.01 | | N |
| ANISOU | 325 | N | GLY | A | 82 | 3601 | 3824 | 3218 | −24 | 539 | −382 | N |
| ATOM | 326 | CA | GLY | A | 82 | −0.338 | 91.591 | 45.726 | 1.00 | 20.47 | | C |
| ANISOU | 326 | CA | GLY | A | 82 | 2579 | 2902 | 2297 | −45 | 638 | −495 | C |
| ATOM | 327 | C | GLY | A | 82 | −1.523 | 90.913 | 45.049 | 1.00 | 23.31 | | C |
| ANISOU | 327 | C | GLY | A | 82 | 2848 | 3236 | 2774 | −27 | 657 | −513 | C |
| ATOM | 328 | O | GLY | A | 82 | −2.662 | 91.089 | 45.495 | 1.00 | 25.61 | | O |
| ANISOU | 328 | O | GLY | A | 82 | 3052 | 3549 | 3132 | −40 | 746 | −618 | O |
| ATOM | 329 | N | SER | A | 83 | −1.264 | 90.114 | 44.007 | 1.00 | 18.68 | | N |
| ANISOU | 329 | N | SER | A | 83 | 2274 | 2606 | 2219 | −3 | 580 | −425 | N |
| ATOM | 330 | CA | SER | A | 83 | −2.316 | 89.293 | 43.399 | 1.00 | 22.32 | | C |
| ANISOU | 330 | CA | SER | A | 83 | 2657 | 3043 | 2782 | −2 | 582 | −439 | C |
| ATOM | 331 | C | SER | A | 83 | −1.787 | 87.921 | 42.975 | 1.00 | 24.85 | | C |
| ANISOU | 331 | C | SER | A | 83 | 3029 | 3346 | 3068 | −32 | 553 | −331 | C |
| ATOM | 332 | O | SER | A | 83 | −0.590 | 87.686 | 43.030 | 1.00 | 25.20 | | O |
| ANISOU | 332 | O | SER | A | 83 | 3157 | 3391 | 3027 | −34 | 523 | −246 | O |
| ATOM | 333 | CB | SER | A | 83 | −2.930 | 90.005 | 42.196 | 1.00 | 24.77 | | C |
| ANISOU | 333 | CB | SER | A | 83 | 2907 | 3283 | 3221 | 85 | 483 | −495 | C |
| ATOM | 334 | OG | SER | A | 83 | −2.062 | 89.948 | 41.074 | 1.00 | 22.68 | | O |
| ANISOU | 334 | OG | SER | A | 83 | 2724 | 2975 | 2920 | 127 | 376 | −416 | O |
| ATOM | 335 | N | SER | A | 84 | −2.673 | 87.022 | 42.542 | 1.00 | 24.42 | | N |
| ANISOU | 335 | N | SER | A | 84 | 2912 | 3265 | 3100 | −52 | 556 | −343 | N |
| ATOM | 336 | CA | SER | A | 84 | −2.270 | 85.617 | 42.359 | 1.00 | 30.67 | | C |
| ANISOU | 336 | CA | SER | A | 84 | 3748 | 4028 | 3876 | −92 | 547 | −255 | C |
| ATOM | 337 | C | SER | A | 84 | −2.279 | 85.149 | 40.908 | 1.00 | 29.38 | | C |
| ANISOU | 337 | C | SER | A | 84 | 3588 | 3797 | 3778 | −40 | 446 | −262 | C |
| ATOM | 338 | O | SER | A | 84 | −1.721 | 84.108 | 40.594 | 1.00 | 23.89 | | O |
| ANISOU | 338 | O | SER | A | 84 | 2942 | 3062 | 3075 | −53 | 427 | −204 | O |
| ATOM | 339 | CB | SER | A | 84 | −3.168 | 84.690 | 43.185 | 1.00 | 30.93 | | C |
| ANISOU | 339 | CB | SER | A | 84 | 3730 | 4078 | 3945 | −190 | 647 | −249 | C |
| ATOM | 340 | OG | SER | A | 84 | −4.471 | 84.563 | 42.614 | 1.00 | 30.95 | | O |
| ANISOU | 340 | OG | SER | A | 84 | 3613 | 4053 | 4093 | −190 | 642 | −337 | O |
| ATOM | 341 | N | SER | A | 85 | −2.861 | 85.946 | 40.020 | 1.00 | 26.31 | | N |
| ANISOU | 341 | N | SER | A | 85 | 3158 | 3391 | 3448 | 20 | 372 | −333 | N |
| ATOM | 342 | CA | SER | A | 85 | −3.074 | 85.517 | 38.650 | 1.00 | 25.10 | | C |
| ANISOU | 342 | CA | SER | A | 85 | 3016 | 3185 | 3336 | 55 | 267 | −354 | C |
| ATOM | 343 | C | SER | A | 85 | −1.948 | 85.880 | 37.713 | 1.00 | 28.09 | | C |
| ANISOU | 343 | C | SER | A | 85 | 3502 | 3550 | 3620 | 110 | 204 | −313 | C |
| ATOM | 344 | O | SER | A | 85 | −1.059 | 86.644 | 38.051 | 1.00 | 31.22 | | O |
| ANISOU | 344 | O | SER | A | 85 | 3945 | 3969 | 3946 | 128 | 228 | −272 | O |
| ATOM | 345 | CB | SER | A | 85 | −4.378 | 86.107 | 38.104 | 1.00 | 21.60 | | C |
| ANISOU | 345 | CB | SER | A | 85 | 2473 | 2726 | 3008 | 86 | 191 | −443 | C |
| ATOM | 346 | OG | SER | A | 85 | −5.497 | 85.602 | 38.810 | 1.00 | 31.25 | | O |
| ANISOU | 346 | OG | SER | A | 85 | 3570 | 3957 | 4346 | 26 | 260 | −494 | O |
| ATOM | 347 | N | LEU | A | 86 | −2.004 | 85.295 | 36.524 | 1.00 | 28.03 | | N |
| ANISOU | 347 | N | LEU | A | 86 | 3532 | 3506 | 3610 | 126 | 130 | −333 | N |
| ATOM | 348 | CA | LEU | A | 86 | −1.206 | 85.712 | 35.386 | 1.00 | 22.64 | | C |
| ANISOU | 348 | CA | LEU | A | 86 | 2951 | 2818 | 2832 | 171 | 73 | −315 | C |
| ATOM | 349 | C | LEU | A | 86 | −2.195 | 85.944 | 34.253 | 1.00 | 25.74 | | C |
| ANISOU | 349 | C | LEU | A | 86 | 3341 | 3189 | 3248 | 196 | −57 | −372 | C |
| ATOM | 350 | O | LEU | A | 86 | −2.863 | 85.013 | 33.810 | 1.00 | 31.09 | | O |
| ANISOU | 350 | O | LEU | A | 86 | 3994 | 3841 | 3976 | 173 | −103 | −426 | O |
| ATOM | 351 | CB | LEU | A | 86 | −0.163 | 84.654 | 35.007 | 1.00 | 18.80 | | C |
| ANISOU | 351 | CB | LEU | A | 86 | 2535 | 2315 | 2295 | 163 | 117 | −293 | C |
| ATOM | 352 | CG | LEU | A | 86 | 1.023 | 85.066 | 34.125 | 1.00 | 24.33 | | C |
| ANISOU | 352 | CG | LEU | A | 86 | 3334 | 3027 | 2885 | 194 | 125 | −266 | C |
| ATOM | 353 | CD1 | LEU | A | 86 | 1.897 | 83.873 | 33.845 | 1.00 | 29.69 | | C |
| ANISOU | 353 | CD1 | LEU | A | 86 | 4045 | 3678 | 3558 | 191 | 183 | −275 | C |
| ATOM | 354 | CD2 | LEU | A | 86 | 0.608 | 85.674 | 32.820 | 1.00 | 29.52 | | C |
| ANISOU | 354 | CD2 | LEU | A | 86 | 4060 | 3687 | 3469 | 216 | 30 | −294 | C |
| ATOM | 355 | N | SER | A | 87 | −2.292 | 87.178 | 33.768 | 1.00 | 27.65 | | N |
| ANISOU | 355 | N | SER | A | 87 | 3613 | 3431 | 3460 | 238 | −134 | −356 | N |
| ATOM | 356 | CA | SER | A | 87 | −3.327 | 87.490 | 32.788 | 1.00 | 19.53 | | C |
| ANISOU | 356 | CA | SER | A | 87 | 2576 | 2377 | 2466 | 265 | −291 | −396 | C |
| ATOM | 357 | C | SER | A | 87 | −3.018 | 88.675 | 31.889 | 1.00 | 21.74 | | C |
| ANISOU | 357 | C | SER | A | 87 | 2960 | 2645 | 2655 | 307 | −390 | −340 | C |
| ATOM | 358 | O | SER | A | 87 | −2.134 | 89.486 | 32.167 | 1.00 | 29.05 | | O |
| ANISOU | 358 | O | SER | A | 87 | 3936 | 3575 | 3525 | 316 | −328 | −276 | O |
| ATOM | 359 | CB | SER | A | 87 | −4.652 | 87.722 | 33.511 | 1.00 | 29.10 | | C |
| ANISOU | 359 | CB | SER | A | 87 | 3623 | 3574 | 3858 | 271 | −317 | −457 | C |
| ATOM | 360 | OG | SER | A | 87 | −4.553 | 88.826 | 34.391 | 1.00 | 30.34 | | O |
| ANISOU | 360 | OG | SER | A | 87 | 3735 | 3734 | 4058 | 297 | −261 | −442 | O |
| ATOM | 361 | N | PHE | A | 88 | −3.767 | 88.760 | 30.798 | 1.00 | 22.39 | | N |
| ANISOU | 361 | N | PHE | A | 88 | 3076 | 2706 | 2723 | 324 | −556 | −358 | N |
| ATOM | 362 | CA | PHE | A | 88 | −3.526 | 89.756 | 29.760 | 1.00 | 27.34 | | C |
| ANISOU | 362 | CA | PHE | A | 88 | 3835 | 3316 | 3236 | 351 | −674 | −285 | C |
| ATOM | 363 | C | PHE | A | 88 | −4.625 | 89.677 | 28.715 | 1.00 | 30.06 | | C |
| ANISOU | 363 | C | PHE | A | 88 | 4192 | 3637 | 3590 | 367 | −892 | −316 | C |
| ATOM | 364 | O | PHE | A | 88 | −5.354 | 88.693 | 28.653 | 1.00 | 31.07 | | O |
| ANISOU | 364 | O | PHE | A | 88 | 4247 | 3771 | 3789 | 346 | −932 | −404 | O |
| ATOM | 365 | CB | PHE | A | 88 | −2.163 | 89.534 | 29.110 | 1.00 | 29.90 | | C |
| ANISOU | 365 | CB | PHE | A | 88 | 4326 | 3681 | 3354 | 316 | −579 | −230 | C |
| ATOM | 366 | CG | PHE | A | 88 | −1.807 | 88.091 | 28.975 | 1.00 | 33.96 | | C |
| ANISOU | 366 | CG | PHE | A | 88 | 4855 | 4228 | 3820 | 278 | −490 | −301 | C |
| ATOM | 367 | CD2 | PHE | A | 88 | −0.903 | 87.506 | 29.834 | 1.00 | 26.78 | | C |
| ANISOU | 367 | CD2 | PHE | A | 88 | 3905 | 3336 | 2935 | 260 | −315 | −302 | C |
| ATOM | 368 | CD1 | PHE | A | 88 | −2.401 | 87.313 | 28.012 | 1.00 | 34.89 | | C |
| ANISOU | 368 | CD1 | PHE | A | 88 | 5023 | 4349 | 3885 | 262 | −597 | −370 | C |
| ATOM | 369 | CE2 | PHE | A | 88 | −0.601 | 86.194 | 29.727 | 1.00 | 27.11 | | C |
| ANISOU | 369 | CE2 | PHE | A | 88 | 3953 | 3381 | 2966 | 235 | −246 | −365 | C |
| ATOM | 370 | CE1 | PHE | A | 88 | −2.080 | 86.011 | 27.900 | 1.00 | 31.81 | | C |
| ANISOU | 370 | CE1 | PHE | A | 88 | 4645 | 3968 | 3474 | 230 | −516 | −447 | C |
| ATOM | 371 | CZ | PHE | A | 88 | −1.176 | 85.446 | 28.762 | 1.00 | 28.22 | | C |
| ANISOU | 371 | CZ | PHE | A | 88 | 4144 | 3515 | 3062 | 221 | −338 | −442 | C |
| ATOM | 372 | N | PRO | A | 89 | −4.764 | 90.727 | 27.900 | 1.00 | 30.81 | | N |
| ANISOU | 372 | N | PRO | A | 89 | 4383 | 3698 | 3625 | 398 | −1048 | −237 | N |
| ATOM | 373 | CA | PRO | A | 89 | −5.718 | 90.640 | 26.795 | 1.00 | 31.31 | | C |
| ANISOU | 373 | CA | PRO | A | 89 | 4487 | 3743 | 3665 | 409 | −1289 | −252 | C |
| ATOM | 374 | C | PRO | A | 89 | −5.404 | 89.475 | 25.873 | 1.00 | 33.34 | | C |
| ANISOU | 374 | C | PRO | A | 89 | 4875 | 4060 | 3732 | 349 | −1287 | −304 | C |
| ATOM | 375 | O | PRO | A | 89 | −4.252 | 89.079 | 25.770 | 1.00 | 31.14 | | O |
| ANISOU | 375 | O | PRO | A | 89 | 4708 | 3829 | 3296 | 309 | −1116 | −289 | O |
| ATOM | 376 | CB | PRO | A | 89 | −5.510 | 91.955 | 26.049 | 1.00 | 26.35 | | C |
| ANISOU | 376 | CB | PRO | A | 89 | 4000 | 3071 | 2939 | 437 | −1425 | −118 | C |
| ATOM | 377 | CG | PRO | A | 89 | −4.952 | 92.894 | 27.064 | 1.00 | 25.17 | | C |
| ANISOU | 377 | CG | PRO | A | 89 | 3790 | 2883 | 2891 | 464 | −1288 | −68 | C |
| ATOM | 378 | CD | PRO | A | 89 | −4.131 | 92.054 | 27.989 | 1.00 | 24.52 | | C |
| ANISOU | 378 | CD | PRO | A | 89 | 3655 | 2864 | 2797 | 422 | −1034 | −127 | C |
| ATOM | 379 | N | CYS | A | 90 | −6.411 | 88.929 | 25.218 | 1.00 | 27.14 | | N |
| ANISOU | 379 | N | CYS | A | 90 | 4067 | 3268 | 2977 | 343 | −1475 | −376 | N |
| ATOM | 380 | CA | CYS | A | 90 | −6.160 | 87.993 | 24.142 | 1.00 | 31.18 | | C |
| ANISOU | 380 | CA | CYS | A | 90 | 4739 | 3829 | 3280 | 286 | −1513 | −433 | C |
| ATOM | 381 | C | CYS | A | 90 | −6.897 | 88.464 | 22.899 | 1.00 | 35.35 | | C |
| ANISOU | 381 | C | CYS | A | 90 | 5385 | 4349 | 3699 | 292 | −1808 | −398 | C |
| ATOM | 382 | O | CYS | A | 90 | −7.816 | 89.257 | 23.010 | 1.00 | 33.63 | | O |
| ANISOU | 382 | O | CYS | A | 90 | 5063 | 4072 | 3644 | 347 | −1996 | −357 | O |
| ATOM | 383 | CB | CYS | A | 90 | −6.576 | 86.595 | 24.553 | 1.00 | 32.59 | | C |
| ANISOU | 383 | CB | CYS | A | 90 | 4793 | 4007 | 3584 | 251 | −1451 | −577 | C |
| ATOM | 384 | SG | CYS | A | 90 | −5.587 | 85.954 | 25.944 | 1.00 | 43.95 | | S |
| ANISOU | 384 | SG | CYS | A | 90 | 6135 | 5452 | 5113 | 235 | −1124 | −590 | S |
| ATOM | 385 | N | ALA | A | 91 | −6.495 | 87.964 | 21.731 | 1.00 | 43.70 | | N |
| ANISOU | 385 | N | ALA | A | 91 | 6658 | 5463 | 4481 | 235 | −1851 | −421 | N |
| ATOM | 386 | CA | ALA | A | 91 | −6.872 | 88.510 | 20.414 | 1.00 | 40.69 | | C |
| ANISOU | 386 | CA | ALA | A | 91 | 6473 | 5095 | 3892 | 222 | −2116 | −353 | C |
| ATOM | 387 | C | ALA | A | 91 | −8.366 | 88.686 | 20.140 | 1.00 | 45.70 | | C |
| ANISOU | 387 | C | ALA | A | 91 | 6993 | 5675 | 4698 | 260 | −2451 | −378 | C |
| ATOM | 388 | O | ALA | A | 91 | −8.752 | 89.455 | 19.256 | 1.00 | 58.42 | | O |
| ANISOU | 388 | O | ALA | A | 91 | 8708 | 7269 | 6218 | 266 | −2648 | −269 | O |
| ATOM | 389 | CB | ALA | A | 91 | −6.258 | 87.655 | 19.305 | 1.00 | 35.45 | | C |
| ANISOU | 389 | CB | ALA | A | 91 | 6046 | 4518 | 2906 | 141 | −2074 | −428 | C |
| ATOM | 390 | N | GLY | A | 92 | −9.226 | 87.986 | 20.856 | 1.00 | 45.03 | | N |
| ANISOU | 390 | N | GLY | A | 92 | 6662 | 5554 | 4894 | 275 | −2464 | −505 | N |
| ATOM | 391 | CA | GLY | A | 92 | −10.646 | 88.202 | 20.610 | 1.00 | 51.54 | | C |
| ANISOU | 391 | CA | GLY | A | 92 | 7343 | 6321 | 5917 | 313 | −2782 | −534 | C |
| ATOM | 392 | C | GLY | A | 92 | −11.111 | 89.551 | 21.132 | 1.00 | 46.68 | | C |
| ANISOU | 392 | C | GLY | A | 92 | 6595 | 5625 | 5518 | 408 | −2873 | −416 | C |
| ATOM | 393 | O | GLY | A | 92 | −12.177 | 90.050 | 20.769 | 1.00 | 46.22 | | O |
| ANISOU | 393 | O | GLY | A | 92 | 6436 | 5503 | 5622 | 447 | −3070 | −389 | O |
| ATOM | 394 | N | CYS | A | 93 | −10.290 | 90.141 | 21.993 | 1.00 | 44.65 | | N |
| ANISOU | 394 | N | CYS | A | 93 | 6321 | 5358 | 5287 | 435 | −2631 | −345 | N |
| ATOM | 395 | CA | CYS | A | 93 | −10.677 | 91.303 | 22.800 | 1.00 | 51.37 | | C |
| ANISOU | 395 | CA | CYS | A | 93 | 7004 | 6120 | 6394 | 526 | −2649 | −279 | C |
| ATOM | 396 | C | CYS | A | 93 | −11.153 | 92.501 | 21.989 | 1.00 | 52.70 | | C |
| ANISOU | 396 | C | CYS | A | 93 | 7256 | 6211 | 6558 | 582 | −2932 | −142 | C |
| ATOM | 397 | O | CYS | A | 93 | −10.456 | 92.962 | 21.086 | 1.00 | 53.17 | | O |
| ANISOU | 397 | O | CYS | A | 93 | 7573 | 6289 | 6341 | 540 | −2941 | −10 | O |
| ATOM | 398 | CB | CYS | A | 93 | −9.509 | 91.754 | 23.686 | 1.00 | 41.56 | | C |
| ANISOU | 398 | CB | CYS | A | 93 | 5793 | 4888 | 5110 | 525 | −2343 | −219 | C |
| ATOM | 399 | SG | CYS | A | 93 | −10.041 | 92.823 | 25.014 | 1.00 | 66.19 | | S |
| ANISOU | 399 | SG | CYS | A | 93 | 8652 | 7909 | 8587 | 623 | −2289 | −223 | S |
| ATOM | 400 | N | LYS | A | 94 | −12.317 | 93.029 | 22.355 | 1.00 | 48.55 | | N |
| ANISOU | 400 | N | LYS | A | 94 | 6495 | 5590 | 6361 | 657 | −3055 | −174 | N |
| ATOM | 401 | CA | LYS | A | 94 | −12.870 | 94.189 | 21.667 | 1.00 | 61.45 | | C |
| ANISOU | 401 | CA | LYS | A | 94 | 8173 | 7124 | 8049 | 701 | −3244 | −52 | C |
| ATOM | 402 | C | LYS | A | 94 | −13.103 | 95.340 | 22.660 | 1.00 | 60.35 | | C |
| ANISOU | 402 | C | LYS | A | 94 | 7854 | 6870 | 8208 | 800 | −3199 | −33 | C |
| ATOM | 403 | O | LYS | A | 94 | −13.486 | 96.446 | 22.279 | 1.00 | 62.24 | | O |
| ANISOU | 403 | O | LYS | A | 94 | 8114 | 7002 | 8533 | 846 | −3335 | 65 | O |
| ATOM | 404 | CB | LYS | A | 94 | −14.192 | 93.811 | 20.980 | 1.00 | 71.01 | | C |
| ANISOU | 404 | CB | LYS | A | 94 | 9282 | 8309 | 9389 | 700 | −3468 | −118 | C |
| ATOM | 405 | CG | LYS | A | 94 | −14.087 | 93.026 | 19.652 | 1.00 | 80.83 | | C |
| ANISOU | 405 | CG | LYS | A | 94 | 10750 | 9641 | 10320 | 608 | −3578 | −105 | C |
| ATOM | 406 | CD | LYS | A | 94 | −12.720 | 93.142 | 18.968 | 1.00 | 84.74 | | C |
| ANISOU | 406 | CD | LYS | A | 94 | 11573 | 10217 | 10409 | 536 | −3468 | 16 | C |
| ATOM | 407 | CE | LYS | A | 94 | −12.632 | 92.277 | 17.701 | 1.00 | 81.81 | | C |
| ANISOU | 407 | CE | LYS | A | 94 | 11407 | 9946 | 9731 | 440 | −3538 | −9 | C |
| ATOM | 408 | NZ | LYS | A | 94 | −13.480 | 92.814 | 16.594 | 1.00 | 80.02 | | N |
| ANISOU | 408 | NZ | LYS | A | 94 | 11246 | 9675 | 9482 | 444 | −3812 | 74 | N |
| ATOM | 409 | N | ASN | A | 95 | −12.819 | 95.074 | 23.930 | 1.00 | 51.54 | | N |
| ANISOU | 409 | N | ASN | A | 95 | 6570 | 5776 | 7238 | 827 | −3000 | −130 | N |
| ATOM | 410 | CA | ASN | A | 95 | −12.978 | 96.048 | 24.992 | 1.00 | 45.13 | | C |
| ANISOU | 410 | CA | ASN | A | 95 | 5579 | 4869 | 6699 | 914 | −2907 | −149 | C |
| ATOM | 411 | C | ASN | A | 95 | −11.763 | 96.134 | 25.906 | 1.00 | 46.41 | | C |
| ANISOU | 411 | C | ASN | A | 95 | 5795 | 5073 | 6766 | 901 | −2638 | −136 | C |
| ATOM | 412 | O | ASN | A | 95 | −11.915 | 96.103 | 27.132 | 1.00 | 50.20 | | O |
| ANISOU | 412 | O | ASN | A | 95 | 6073 | 5555 | 7446 | 920 | −2426 | −253 | O |
| ATOM | 413 | CB | ASN | A | 95 | −14.221 | 95.718 | 25.827 | 1.00 | 50.52 | | C |
| ANISOU | 413 | CB | ASN | A | 95 | 5923 | 5528 | 7744 | 956 | −2875 | −328 | C |
| ATOM | 414 | CG | ASN | A | 95 | −15.517 | 95.875 | 25.040 | 1.00 | 71.42 | | C |
| ANISOU | 414 | CG | ASN | A | 95 | 8490 | 8103 | 10541 | 973 | −3109 | −343 | C |
| ATOM | 415 | OD1 | ASN | A | 95 | −15.756 | 96.911 | 24.410 | 1.00 | 75.99 | | O |
| ANISOU | 415 | OD1 | ASN | A | 95 | 9153 | 8581 | 11139 | 1013 | −3274 | −236 | O |
| ATOM | 416 | ND2 | ASN | A | 95 | −16.363 | 94.845 | 25.074 | 1.00 | 78.75 | | N |
| ANISOU | 416 | ND2 | ASN | A | 95 | 9255 | 9079 | 11589 | 938 | −3130 | −473 | N |
| ATOM | 417 | N | CYS | A | 96 | −10.563 | 96.225 | 25.323 | 1.00 | 43.27 | | N |
| ANISOU | 417 | N | CYS | A | 96 | 5678 | 4720 | 6043 | 833 | −2570 | −5 | N |
| ATOM | 418 | CA | CYS | A | 96 | −9.324 | 96.338 | 26.122 | 1.00 | 37.64 | | C |
| ANISOU | 418 | CA | CYS | A | 96 | 5030 | 4049 | 5221 | 787 | −2258 | 12 | C |
| ATOM | 419 | C | CYS | A | 96 | −8.524 | 97.590 | 25.786 | 1.00 | 35.93 | | C |
| ANISOU | 419 | C | CYS | A | 96 | 4997 | 3750 | 4906 | 797 | −2290 | 181 | C |
| ATOM | 420 | O | CYS | A | 96 | −8.864 | 98.344 | 24.872 | 1.00 | 38.57 | | O |
| ANISOU | 420 | O | CYS | A | 96 | 5438 | 3993 | 5222 | 832 | −2550 | 308 | O |
| ATOM | 421 | CB | CYS | A | 96 | −8.418 | 95.114 | 25.931 | 1.00 | 36.96 | | C |
| ANISOU | 421 | CB | CYS | A | 96 | 5077 | 4105 | 4862 | 679 | −2066 | −13 | C |
| ATOM | 422 | SG | CYS | A | 96 | −9.035 | 93.532 | 26.633 | 1.00 | 68.24 | | S |
| ANISOU | 422 | SG | CYS | A | 96 | 8834 | 8156 | 8940 | 641 | −1935 | −207 | S |
| ATOM | 423 | N | GLY | A | 97 | −7.440 | 97.789 | 26.520 | 1.00 | 34.04 | | N |
| ANISOU | 423 | N | GLY | A | 97 | 4796 | 3536 | 4601 | 756 | −2033 | 192 | N |
| ATOM | 424 | CA | GLY | A | 97 | −6.566 | 98.928 | 26.310 | 1.00 | 32.66 | | C |
| ANISOU | 424 | CA | GLY | A | 97 | 4782 | 3282 | 4346 | 744 | −2024 | 344 | C |
| ATOM | 425 | C | GLY | A | 97 | −5.460 | 98.578 | 25.338 | 1.00 | 35.84 | | C |
| ANISOU | 425 | C | GLY | A | 97 | 5449 | 3775 | 4395 | 637 | −1961 | 466 | C |
| ATOM | 426 | O | GLY | A | 97 | −5.215 | 97.397 | 25.081 | 1.00 | 40.11 | | O |
| ANISOU | 426 | O | GLY | A | 97 | 6028 | 4445 | 4768 | 578 | −1867 | 400 | O |
| ATOM | 427 | N | VAL | A | 98 | −4.831 | 99.602 | 24.765 | 1.00 | 38.86 | | N |
| ANISOU | 427 | N | VAL | A | 98 | 6013 | 4079 | 4673 | 611 | −2015 | 639 | N |
| ATOM | 428 | CA | VAL | A | 98 | −3.660 | 99.430 | 23.912 | 1.00 | 37.32 | | C |
| ANISOU | 428 | CA | VAL | A | 98 | 6064 | 3966 | 4147 | 496 | −1908 | 759 | C |
| ATOM | 429 | C | VAL | A | 98 | −2.418 | 99.280 | 24.802 | 1.00 | 40.33 | | C |
| ANISOU | 429 | C | VAL | A | 98 | 6407 | 4407 | 4509 | 440 | −1593 | 714 | C |
| ATOM | 430 | O | VAL | A | 98 | −2.244 | 100.040 | 25.758 | 1.00 | 42.68 | | O |
| ANISOU | 430 | O | VAL | A | 98 | 6594 | 4620 | 5003 | 474 | −1525 | 698 | O |
| ATOM | 431 | CB | VAL | A | 98 | −3.477 | 100.639 | 22.953 | 1.00 | 41.03 | | C |
| ANISOU | 431 | CB | VAL | A | 98 | 6744 | 4325 | 4519 | 470 | −2077 | 980 | C |
| ATOM | 432 | CG1 | VAL | A | 98 | −2.258 | 100.448 | 22.078 | 1.00 | 43.82 | | C |
| ANISOU | 432 | CG1 | VAL | A | 98 | 7325 | 4787 | 4536 | 332 | −1906 | 1082 | C |
| ATOM | 433 | CG2 | VAL | A | 98 | −4.726 | 100.865 | 22.095 | 1.00 | 37.22 | | C |
| ANISOU | 433 | CG2 | VAL | A | 98 | 6241 | 3801 | 4101 | 509 | −2338 | 994 | C |
| ATOM | 434 | N | HIS | A | 99 | −1.545 | 98.322 | 24.492 | 1.00 | 38.74 | | N |
| ANISOU | 434 | N | HIS | A | 99 | 6292 | 4345 | 4083 | 356 | −1409 | 687 | N |
| ATOM | 435 | CA | HIS | A | 99 | −0.335 | 98.108 | 25.304 | 1.00 | 32.49 | | C |
| ANISOU | 435 | CA | HIS | A | 99 | 5450 | 3610 | 3286 | 306 | −1131 | 646 | C |
| ATOM | 436 | C | HIS | A | 99 | 0.927 | 97.982 | 24.429 | 1.00 | 30.32 | | C |
| ANISOU | 436 | C | HIS | A | 99 | 5371 | 3412 | 2737 | 195 | −984 | 742 | C |
| ATOM | 437 | O | HIS | A | 99 | 0.842 | 98.097 | 23.209 | 1.00 | 38.01 | | O |
| ANISOU | 437 | O | HIS | A | 99 | 6539 | 4401 | 3503 | 150 | −1090 | 843 | O |
| ATOM | 438 | CB | HIS | A | 99 | −0.499 | 96.871 | 26.181 | 1.00 | 25.56 | | C |
| ANISOU | 438 | CB | HIS | A | 99 | 4400 | 2821 | 2488 | 329 | −1003 | 469 | C |
| ATOM | 439 | CG | HIS | A | 99 | −1.763 | 96.854 | 26.992 | 1.00 | 44.00 | | C |
| ANISOU | 439 | CG | HIS | A | 99 | 6540 | 5104 | 5073 | 419 | −1112 | 362 | C |
| ATOM | 440 | ND1 | HIS | A | 99 | −1.955 | 97.655 | 28.100 | 1.00 | 42.94 | | N |
| ANISOU | 440 | ND1 | HIS | A | 99 | 6267 | 4889 | 5161 | 469 | −1087 | 328 | N |
| ATOM | 441 | CD2 | HIS | A | 99 | −2.900 | 96.127 | 26.858 | 1.00 | 37.13 | | C |
| ANISOU | 441 | CD2 | HIS | A | 99 | 5583 | 4253 | 4272 | 460 | −1235 | 269 | C |
| ATOM | 442 | CE1 | HIS | A | 99 | −3.149 | 97.418 | 28.615 | 1.00 | 32.86 | | C |
| ANISOU | 442 | CE1 | HIS | A | 99 | 4822 | 3589 | 4074 | 539 | −1169 | 217 | C |
| ATOM | 443 | NE2 | HIS | A | 99 | −3.749 | 96.505 | 27.872 | 1.00 | 31.22 | | N |
| ANISOU | 443 | NE2 | HIS | A | 99 | 4635 | 3439 | 3788 | 533 | −1266 | 186 | N |
| ATOM | 444 | N | MET | A | 100 | 2.086 | 97.778 | 25.055 | 1.00 | 30.91 | | N |
| ANISOU | 444 | N | MET | A | 100 | 5393 | 3537 | 2813 | 147 | −745 | 710 | N |
| ATOM | 445 | CA | MET | A | 100 | 3.344 | 97.552 | 24.329 | 1.00 | 40.75 | | C |
| ANISOU | 445 | CA | MET | A | 100 | 6779 | 4867 | 3838 | 43 | −564 | 770 | C |
| ATOM | 446 | C | MET | A | 100 | 3.268 | 96.446 | 23.290 | 1.00 | 38.24 | | C |
| ANISOU | 446 | C | MET | A | 100 | 6579 | 4664 | 3285 | 10 | −549 | 716 | C |
| ATOM | 447 | O | MET | A | 100 | 3.891 | 96.535 | 22.239 | 1.00 | 47.89 | | O |
| ANISOU | 447 | O | MET | A | 100 | 7987 | 5938 | 4270 | −76 | −484 | 798 | O |
| ATOM | 448 | CB | MET | A | 100 | 4.478 | 97.198 | 25.285 | 1.00 | 51.14 | | C |
| ANISOU | 448 | CB | MET | A | 100 | 7963 | 6230 | 5239 | 18 | −325 | 699 | C |
| ATOM | 449 | CG | MET | A | 100 | 5.179 | 98.352 | 25.920 | 1.00 | 58.27 | | C |
| ANISOU | 449 | CG | MET | A | 100 | 8826 | 7047 | 6269 | −12 | −270 | 780 | C |
| ATOM | 450 | SD | MET | A | 100 | 6.473 | 97.647 | 26.934 | 1.00 | 52.76 | | S |
| ANISOU | 450 | SD | MET | A | 100 | 7969 | 6429 | 5648 | −41 | −21 | 679 | S |
| ATOM | 451 | CE | MET | A | 100 | 5.522 | 97.306 | 28.386 | 1.00 | 26.90 | | C |
| ANISOU | 451 | CE | MET | A | 100 | 4501 | 3127 | 2592 | 64 | −104 | 543 | C |
| ATOM | 452 | N | GLU | A | 101 | 2.543 | 95.385 | 23.612 | 1.00 | 31.18 | | N |
| ANISOU | 452 | N | GLU | A | 101 | 5577 | 3811 | 2457 | 70 | −592 | 569 | N |
| ATOM | 453 | CA | GLU | A | 101 | 2.410 | 94.252 | 22.704 | 1.00 | 37.96 | | C |
| ANISOU | 453 | CA | GLU | A | 101 | 6535 | 4767 | 3122 | 43 | −586 | 485 | C |
| ATOM | 454 | C | GLU | A | 101 | 0.963 | 94.071 | 22.291 | 1.00 | 40.31 | | C |
| ANISOU | 454 | C | GLU | A | 101 | 6844 | 5036 | 3437 | 96 | −854 | 454 | C |
| ATOM | 455 | O | GLU | A | 101 | 0.059 | 94.520 | 22.986 | 1.00 | 38.18 | | O |
| ANISOU | 455 | O | GLU | A | 101 | 6435 | 4681 | 3388 | 170 | −998 | 450 | O |
| ATOM | 456 | CB | GLU | A | 101 | 2.947 | 92.964 | 23.347 | 1.00 | 33.97 | | C |
| ANISOU | 456 | CB | GLU | A | 101 | 5896 | 4329 | 2681 | 53 | −390 | 328 | C |
| ATOM | 457 | CG | GLU | A | 101 | 4.464 | 92.940 | 23.484 | 1.00 | 33.11 | | C |
| ANISOU | 457 | CG | GLU | A | 101 | 5788 | 4267 | 2527 | −5 | −131 | 344 | C |
| ATOM | 458 | CD | GLU | A | 101 | 4.953 | 93.521 | 24.790 | 1.00 | 43.78 | | C |
| ANISOU | 458 | CD | GLU | A | 101 | 6973 | 5563 | 4097 | 19 | −56 | 372 | C |
| ATOM | 459 | OE1 | GLU | A | 101 | 4.238 | 93.373 | 25.808 | 1.00 | 44.51 | | O |
| ANISOU | 459 | OE1 | GLU | A | 101 | 6916 | 5613 | 4381 | 86 | −132 | 313 | O |
| ATOM | 460 | OE2 | GLU | A | 101 | 6.063 | 94.104 | 24.801 | 1.00 | 47.13 | | O |
| ANISOU | 460 | OE2 | GLU | A | 101 | 7417 | 5991 | 4500 | −38 | 86 | 445 | O |
| ATOM | 461 | N | ASN | A | 102 | 0.751 | 93.438 | 21.141 | 1.00 | 47.61 | | N |
| ANISOU | 461 | N | ASN | A | 102 | 7929 | 6030 | 4130 | 54 | −920 | 422 | N |
| ATOM | 462 | CA | ASN | A | 102 | −0.588 | 93.056 | 20.726 | 1.00 | 43.22 | | C |
| ANISOU | 462 | CA | ASN | A | 102 | 7369 | 5459 | 3593 | 95 | −1180 | 365 | C |
| ATOM | 463 | C | ASN | A | 102 | −1.136 | 92.050 | 21.727 | 1.00 | 43.86 | | C |
| ANISOU | 463 | C | ASN | A | 102 | 7216 | 5536 | 3912 | 154 | −1143 | 195 | C |
| ATOM | 464 | O | ASN | A | 102 | −0.361 | 91.371 | 22.396 | 1.00 | 45.07 | | O |
| ANISOU | 464 | O | ASN | A | 102 | 7280 | 5725 | 4118 | 145 | −915 | 115 | O |
| ATOM | 465 | CB | ASN | A | 102 | −0.577 | 92.461 | 19.318 | 1.00 | 43.73 | | C |
| ANISOU | 465 | CB | ASN | A | 102 | 7665 | 5615 | 3338 | 24 | −1237 | 339 | C |
| ATOM | 466 | CG | ASN | A | 102 | −0.044 | 93.421 | 18.280 | 1.00 | 52.11 | | C |
| ANISOU | 466 | CG | ASN | A | 102 | 8876 | 6693 | 4228 | −51 | −1207 | 500 | C |
| ATOM | 467 | OD1 | ASN | A | 102 | 0.995 | 93.166 | 17.673 | 1.00 | 58.22 | | O |
| ANISOU | 467 | OD1 | ASN | A | 102 | 9743 | 7558 | 4819 | −131 | −987 | 491 | O |
| ATOM | 468 | ND2 | ASN | A | 102 | −0.753 | 94.528 | 18.063 | 1.00 | 36.97 | | N |
| ANISOU | 468 | ND2 | ASN | A | 102 | 6973 | 4685 | 2389 | −24 | −1427 | 642 | N |
| ATOM | 469 | N | PRO | A | 103 | −2.471 | 91.963 | 21.851 | 1.00 | 40.61 | | N |
| ANISOU | 469 | N | PRO | A | 103 | 6697 | 5074 | 3658 | 211 | −1370 | 147 | N |
| ATOM | 470 | CA | PRO | A | 103 | −3.086 | 90.960 | 22.724 | 1.00 | 33.89 | | C |
| ANISOU | 470 | CA | PRO | A | 103 | 5633 | 4220 | 3025 | 247 | −1336 | −8 | C |
| ATOM | 471 | C | PRO | A | 103 | −2.557 | 89.560 | 22.386 | 1.00 | 41.33 | | C |
| ANISOU | 471 | C | PRO | A | 103 | 6627 | 5241 | 3837 | 194 | −1191 | −138 | C |
| ATOM | 472 | O | PRO | A | 103 | −2.250 | 89.302 | 21.219 | 1.00 | 43.16 | | O |
| ANISOU | 472 | O | PRO | A | 103 | 7060 | 5530 | 3809 | 140 | −1218 | −143 | O |
| ATOM | 473 | CB | PRO | A | 103 | −4.574 | 91.077 | 22.394 | 1.00 | 30.61 | | C |
| ANISOU | 473 | CB | PRO | A | 103 | 5151 | 3754 | 2725 | 290 | −1634 | −32 | C |
| ATOM | 474 | CG | PRO | A | 103 | −4.745 | 92.442 | 21.874 | 1.00 | 31.59 | | C |
| ANISOU | 474 | CG | PRO | A | 103 | 5381 | 3816 | 2804 | 314 | −1812 | 130 | C |
| ATOM | 475 | CD | PRO | A | 103 | −3.483 | 92.753 | 21.129 | 1.00 | 32.06 | | C |
| ANISOU | 475 | CD | PRO | A | 103 | 5685 | 3931 | 2564 | 239 | −1679 | 238 | C |
| ATOM | 476 | N | PHE | A | 104 | −2.439 | 88.680 | 23.373 | 1.00 | 39.44 | | N |
| ANISOU | 476 | N | PHE | A | 104 | 6221 | 4997 | 3765 | 206 | −1040 | −240 | N |
| ATOM | 477 | CA | PHE | A | 104 | −1.898 | 87.347 | 23.122 | 1.00 | 39.62 | | C |
| ANISOU | 477 | CA | PHE | A | 104 | 6280 | 5065 | 3706 | 167 | −901 | −364 | C |
| ATOM | 478 | C | PHE | A | 104 | −2.768 | 86.590 | 22.119 | 1.00 | 42.44 | | C |
| ANISOU | 478 | C | PHE | A | 104 | 6715 | 5435 | 3974 | 140 | −1085 | −471 | C |
| ATOM | 479 | O | PHE | A | 104 | −3.984 | 86.506 | 22.292 | 1.00 | 50.76 | | O |
| ANISOU | 479 | O | PHE | A | 104 | 7654 | 6446 | 5186 | 163 | −1273 | −509 | O |
| ATOM | 480 | CB | PHE | A | 104 | −1.781 | 86.559 | 24.424 | 1.00 | 34.35 | | C |
| ANISOU | 480 | CB | PHE | A | 104 | 5417 | 4368 | 3265 | 186 | −750 | −433 | C |
| ATOM | 481 | CG | PHE | A | 104 | −1.266 | 85.148 | 24.237 | 1.00 | 39.94 | | C |
| ANISOU | 481 | CG | PHE | A | 104 | 6145 | 5089 | 3940 | 156 | −623 | −559 | C |
| ATOM | 482 | CD1 | PHE | A | 104 | 0.082 | 84.911 | 24.012 | 1.00 | 44.13 | | C |
| ANISOU | 482 | CD1 | PHE | A | 104 | 6761 | 5658 | 4350 | 140 | −424 | −562 | C |
| ATOM | 483 | CD2 | PHE | A | 104 | −2.127 | 84.059 | 24.309 | 1.00 | 29.07 | | C |
| ANISOU | 483 | CD2 | PHE | A | 104 | 4688 | 3676 | 2682 | 145 | −700 | −680 | C |
| ATOM | 484 | CE1 | PHE | A | 104 | 0.557 | 83.616 | 23.853 | 1.00 | 40.43 | | C |
| ANISOU | 484 | CE1 | PHE | A | 104 | 6297 | 5182 | 3884 | 126 | −309 | −691 | C |
| ATOM | 485 | CE2 | PHE | A | 104 | −1.653 | 82.770 | 24.148 | 1.00 | 30.48 | | C |
| ANISOU | 485 | CE2 | PHE | A | 104 | 4885 | 3841 | 2855 | 122 | −589 | −800 | C |
| ATOM | 486 | CZ | PHE | A | 104 | −0.314 | 82.549 | 23.919 | 1.00 | 32.57 | | C |
| ANISOU | 486 | CZ | PHE | A | 104 | 5235 | 4135 | 3004 | 119 | −397 | −809 | C |
| ATOM | 487 | N | ASN | A | 105 | −2.155 | 86.054 | 21.065 | 1.00 | 32.10 | | N |
| ANISOU | 487 | N | ASN | A | 105 | 5595 | 4187 | 2415 | 89 | −1030 | −531 | N |
| ATOM | 488 | CA | ASN | A | 105 | −2.942 | 85.419 | 20.022 | 1.00 | 39.27 | | C |
| ANISOU | 488 | CA | ASN | A | 105 | 6608 | 5114 | 3199 | 54 | −1223 | −639 | C |
| ATOM | 489 | C | ASN | A | 105 | −3.013 | 83.909 | 20.220 | 1.00 | 41.04 | | C |
| ANISOU | 489 | C | ASN | A | 105 | 6753 | 5316 | 3525 | 38 | −1142 | −827 | C |
| ATOM | 490 | O | ASN | A | 105 | −2.049 | 83.197 | 19.935 | 1.00 | 40.85 | | O |
| ANISOU | 490 | O | ASN | A | 105 | 6811 | 5322 | 3390 | 12 | −947 | −914 | O |
| ATOM | 491 | CB | ASN | A | 105 | −2.373 | 85.747 | 18.639 | 1.00 | 46.99 | | C |
| ANISOU | 491 | CB | ASN | A | 105 | 7871 | 6175 | 3807 | −6 | −1236 | −607 | C |
| ATOM | 492 | CG | ASN | A | 105 | −3.385 | 85.525 | 17.525 | 1.00 | 56.70 | | C |
| ANISOU | 492 | CG | ASN | A | 105 | 9189 | 7428 | 4926 | −42 | −1492 | −656 | C |
| ATOM | 493 | OD1 | ASN | A | 105 | −4.183 | 84.585 | 17.573 | 1.00 | 59.00 | | O |
| ANISOU | 493 | OD1 | ASN | A | 105 | 9394 | 7687 | 5336 | −43 | −1605 | −804 | O |
| ATOM | 494 | ND2 | ASN | A | 105 | −3.354 | 86.391 | 16.513 | 1.00 | 62.94 | | N |
| ANISOU | 494 | ND2 | ASN | A | 105 | 10118 | 8271 | 5525 | −77 | −1567 | −522 | N |
| ATOM | 495 | N | LEU | A | 106 | −4.165 | 83.442 | 20.701 | 1.00 | 39.87 | | N |
| ANISOU | 495 | N | LEU | A | 106 | 6436 | 5106 | 3608 | 51 | −1290 | −892 | N |
| ATOM | 496 | CA | LEU | A | 106 | −4.379 | 82.035 | 21.021 | 1.00 | 45.27 | | C |
| ANISOU | 496 | CA | LEU | A | 106 | 7019 | 5739 | 4442 | 29 | −1232 | −1054 | C |
| ATOM | 497 | C | LEU | A | 106 | −4.344 | 81.137 | 19.804 | 1.00 | 51.74 | | C |
| ANISOU | 497 | C | LEU | A | 106 | 8013 | 6585 | 5060 | −26 | −1289 | −1217 | C |
| ATOM | 498 | O | LEU | A | 106 | −3.885 | 80.001 | 19.886 | 1.00 | 60.68 | | O |
| ANISOU | 498 | O | LEU | A | 106 | 9136 | 7682 | 6239 | −44 | −1146 | −1351 | O |
| ATOM | 499 | CB | LEU | A | 106 | −5.718 | 81.841 | 21.731 | 1.00 | 43.48 | | C |
| ANISOU | 499 | CB | LEU | A | 106 | 6572 | 5443 | 4505 | 37 | −1387 | −1078 | C |
| ATOM | 500 | CG | LEU | A | 106 | −5.789 | 82.503 | 23.105 | 1.00 | 44.80 | | C |
| ANISOU | 500 | CG | LEU | A | 106 | 6546 | 5581 | 4897 | 84 | −1290 | −961 | C |
| ATOM | 501 | CD1 | LEU | A | 106 | −6.871 | 83.566 | 23.099 | 1.00 | 55.43 | | C |
| ANISOU | 501 | CD1 | LEU | A | 106 | 7809 | 6917 | 6335 | 119 | −1511 | −887 | C |
| ATOM | 502 | CD2 | LEU | A | 106 | −6.051 | 81.480 | 24.173 | 1.00 | 36.17 | | C |
| ANISOU | 502 | CD2 | LEU | A | 106 | 5265 | 4421 | 4055 | 65 | −1176 | −1028 | C |
| ATOM | 503 | N | ASN | A | 107 | −4.844 | 81.624 | 18.676 | 1.00 | 49.23 | | N |
| ANISOU | 503 | N | ASN | A | 107 | 7862 | 6322 | 4523 | −54 | −1509 | −1210 | N |
| ATOM | 504 | CA | ASN | A | 107 | −4.914 | 80.760 | 17.505 | 1.00 | 51.60 | | C |
| ANISOU | 504 | CA | ASN | A | 107 | 8301 | 6659 | 4645 | −119 | −1553 | −1363 | C |
| ATOM | 505 | C | ASN | A | 107 | −3.500 | 80.459 | 16.993 | 1.00 | 52.26 | | C |
| ANISOU | 505 | C | ASN | A | 107 | 8532 | 6811 | 4513 | −141 | −1270 | −1407 | C |
| ATOM | 506 | O | ASN | A | 107 | −3.274 | 79.439 | 16.351 | 1.00 | 51.14 | | O |
| ANISOU | 506 | O | ASN | A | 107 | 8440 | 6684 | 4309 | −184 | −1194 | −1574 | O |
| ATOM | 507 | CB | ASN | A | 107 | −5.788 | 81.379 | 16.405 | 1.00 | 51.52 | | C |
| ANISOU | 507 | CB | ASN | A | 107 | 8366 | 6711 | 4499 | −152 | −1803 | −1293 | C |
| ATOM | 508 | CG | ASN | A | 107 | −7.273 | 81.044 | 16.577 | 1.00 | 57.90 | | C |
| ANISOU | 508 | CG | ASN | A | 107 | 9005 | 7449 | 5545 | −154 | −2069 | −1349 | C |
| ATOM | 509 | OD1 | ASN | A | 107 | −7.617 | 80.047 | 17.204 | 1.00 | 62.44 | | O |
| ANISOU | 509 | OD1 | ASN | A | 107 | 9438 | 7944 | 6341 | −163 | −2047 | −1485 | O |
| ATOM | 510 | ND2 | ASN | A | 107 | −8.153 | 81.859 | 15.984 | 1.00 | 59.79 | | N |
| ANISOU | 510 | ND2 | ASN | A | 107 | 9251 | 7710 | 5755 | −149 | −2315 | −1243 | N |
| ATOM | 511 | N | ASN | A | 108 | −2.554 | 81.343 | 17.311 | 1.00 | 49.01 | | N |
| ANISOU | 511 | N | ASN | A | 108 | 8168 | 6437 | 4018 | −113 | −1110 | −1266 | N |
| ATOM | 512 | CA | ASN | A | 108 | −1.165 | 81.216 | 16.870 | 1.00 | 45.43 | | C |
| ANISOU | 512 | CA | ASN | A | 108 | 7811 | 6055 | 3397 | −132 | −826 | −1288 | C |
| ATOM | 513 | C | ASN | A | 108 | −0.277 | 80.404 | 17.817 | 1.00 | 41.88 | | C |
| ANISOU | 513 | C | ASN | A | 108 | 7263 | 5531 | 3117 | −90 | −583 | −1382 | C |
| ATOM | 514 | O | ASN | A | 108 | 0.869 | 80.090 | 17.486 | 1.00 | 43.07 | | O |
| ANISOU | 514 | O | ASN | A | 108 | 7447 | 5728 | 3191 | −97 | −342 | −1436 | O |
| ATOM | 515 | CB | ASN | A | 108 | −0.547 | 82.602 | 16.690 | 1.00 | 46.22 | | C |
| ANISOU | 515 | CB | ASN | A | 108 | 7991 | 6225 | 3344 | −136 | −767 | −1078 | C |
| ATOM | 516 | CG | ASN | A | 108 | −1.163 | 83.370 | 15.556 | 1.00 | 45.62 | | C |
| ANISOU | 516 | CG | ASN | A | 108 | 8042 | 6221 | 3070 | −180 | −966 | −978 | C |
| ATOM | 517 | OD1 | ASN | A | 108 | −1.786 | 82.794 | 14.667 | 1.00 | 41.91 | | O |
| ANISOU | 517 | OD1 | ASN | A | 108 | 7629 | 5787 | 2509 | −219 | −1096 | −1085 | O |
| ATOM | 518 | ND2 | ASN | A | 108 | −0.994 | 84.690 | 15.577 | 1.00 | 45.58 | | N |
| ANISOU | 518 | ND2 | ASN | A | 108 | 8083 | 6231 | 3006 | −176 | −996 | −769 | N |
| ATOM | 519 | N | SER | A | 109 | −0.795 | 80.066 | 18.991 | 1.00 | 33.87 | | N |
| ANISOU | 519 | N | SER | A | 109 | 6043 | 4416 | 2409 | −46 | −623 | −1369 | N |
| ATOM | 520 | CA | SER | A | 109 | −0.064 | 79.183 | 19.899 | 1.00 | 40.89 | | C |
| ANISOU | 520 | CA | SER | A | 109 | 6784 | 5228 | 3525 | −10 | −411 | −1426 | C |
| ATOM | 521 | C | SER | A | 109 | −0.558 | 77.744 | 19.766 | 1.00 | 36.95 | | C |
| ANISOU | 521 | C | SER | A | 109 | 6249 | 4638 | 3153 | −28 | −456 | −1628 | C |
| ATOM | 522 | O | SER | A | 109 | −1.707 | 77.452 | 20.088 | 1.00 | 33.47 | | O |
| ANISOU | 522 | O | SER | A | 109 | 5710 | 4136 | 2873 | −43 | −639 | −1644 | O |
| ATOM | 523 | CB | SER | A | 109 | −0.198 | 79.648 | 21.353 | 1.00 | 35.84 | | C |
| ANISOU | 523 | CB | SER | A | 109 | 5934 | 4536 | 3146 | 36 | −392 | −1269 | C |
| ATOM | 524 | OG | SER | A | 109 | 0.376 | 78.692 | 22.234 | 1.00 | 42.16 | | O |
| ANISOU | 524 | OG | SER | A | 109 | 6601 | 5252 | 4165 | 64 | −233 | −1316 | O |
| ATOM | 525 | N | LYS | A | 110 | 0.319 | 76.855 | 19.294 | 1.00 | 39.64 | | N |
| ANISOU | 525 | N | LYS | A | 110 | 6661 | 4962 | 3440 | −28 | −283 | −1788 | N |
| ATOM | 526 | CA | LYS | A | 110 | −0.035 | 75.455 | 19.032 | 1.00 | 37.09 | | C |
| ANISOU | 526 | CA | LYS | A | 110 | 6330 | 4536 | 3227 | −47 | −314 | −2005 | C |
| ATOM | 527 | C | LYS | A | 110 | −0.364 | 74.706 | 20.317 | 1.00 | 40.71 | | C |
| ANISOU | 527 | C | LYS | A | 110 | 6567 | 4848 | 4055 | −21 | −310 | −1973 | C |
| ATOM | 528 | O | LYS | A | 110 | −0.969 | 73.624 | 20.285 | 1.00 | 40.48 | | O |
| ANISOU | 528 | O | LYS | A | 110 | 6497 | 4707 | 4175 | −50 | −389 | −2115 | O |
| ATOM | 529 | CB | LYS | A | 110 | 1.114 | 74.731 | 18.313 | 1.00 | 42.60 | | C |
| ANISOU | 529 | CB | LYS | A | 110 | 7106 | 5248 | 3832 | −40 | −92 | −2174 | C |
| ATOM | 530 | CG | LYS | A | 110 | 1.605 | 75.413 | 17.052 | 1.00 | 53.76 | | C |
| ANISOU | 530 | CG | LYS | A | 110 | 8648 | 6847 | 4930 | −68 | −42 | −2161 | C |
| ATOM | 531 | CD | LYS | A | 110 | 2.844 | 74.724 | 16.483 | 1.00 | 58.23 | | C |
| ANISOU | 531 | CD | LYS | A | 110 | 9221 | 7432 | 5471 | −12 | 184 | −2296 | C |
| ATOM | 532 | CE | LYS | A | 110 | 3.205 | 75.284 | 15.110 | 1.00 | 61.23 | | C |
| ANISOU | 532 | CE | LYS | A | 110 | 9749 | 7993 | 5523 | −47 | 219 | −2300 | C |
| ATOM | 533 | NZ | LYS | A | 110 | 4.402 | 74.615 | 14.528 | 1.00 | 66.38 | | N |
| ANISOU | 533 | NZ | LYS | A | 110 | 10418 | 8654 | 6150 | 12 | 444 | −2431 | N |
| ATOM | 534 | N | THR | A | 111 | 0.023 | 75.292 | 21.444 | 1.00 | 32.25 | | N |
| ANISOU | 534 | N | THR | A | 111 | 5360 | 3773 | 3119 | 22 | −223 | −1785 | N |
| ATOM | 535 | CA | THR | A | 111 | −0.164 | 74.656 | 22.726 | 1.00 | 30.91 | | C |
| ANISOU | 535 | CA | THR | A | 111 | 5003 | 3480 | 3262 | 39 | −198 | −1727 | C |
| ATOM | 536 | C | THR | A | 111 | −1.218 | 75.343 | 23.607 | 1.00 | 35.44 | | C |
| ANISOU | 536 | C | THR | A | 111 | 5449 | 4065 | 3953 | 22 | −332 | −1570 | C |
| ATOM | 537 | O | THR | A | 111 | −1.389 | 74.968 | 24.765 | 1.00 | 35.32 | | O |
| ANISOU | 537 | O | THR | A | 111 | 5286 | 3969 | 4167 | 23 | −297 | −1494 | O |
| ATOM | 538 | CB | THR | A | 111 | 1.164 | 74.596 | 23.509 | 1.00 | 33.37 | | C |
| ANISOU | 538 | CB | THR | A | 111 | 5243 | 3765 | 3671 | 101 | 17 | −1647 | C |
| ATOM | 539 | OG1 | THR | A | 111 | 1.846 | 75.858 | 23.431 | 1.00 | 37.33 | | O |
| ANISOU | 539 | OG1 | THR | A | 111 | 5790 | 4394 | 3998 | 123 | 90 | −1521 | O |
| ATOM | 540 | CG2 | THR | A | 111 | 2.071 | 73.493 | 22.965 | 1.00 | 31.26 | | C |
| ANISOU | 540 | CG2 | THR | A | 111 | 5023 | 3419 | 3433 | 128 | 157 | −1829 | C |
| ATOM | 541 | N | SER | A | 112 | −1.919 | 76.346 | 23.088 | 1.00 | 29.76 | | N |
| ANISOU | 541 | N | SER | A | 112 | 4784 | 3440 | 3082 | 5 | −483 | −1522 | N |
| ATOM | 542 | CA | SER | A | 112 | −2.953 | 77.019 | 23.891 | 1.00 | 36.32 | | C |
| ANISOU | 542 | CA | SER | A | 112 | 5475 | 4275 | 4049 | −2 | −604 | −1398 | C |
| ATOM | 543 | C | SER | A | 112 | −4.219 | 76.172 | 24.073 | 1.00 | 37.49 | | C |
| ANISOU | 543 | C | SER | A | 112 | 5511 | 4334 | 4402 | −57 | −745 | −1486 | C |
| ATOM | 544 | O | SER | A | 112 | −4.632 | 75.433 | 23.173 | 1.00 | 32.66 | | O |
| ANISOU | 544 | O | SER | A | 112 | 4971 | 3689 | 3751 | −98 | −852 | −1645 | O |
| ATOM | 545 | CB | SER | A | 112 | −3.325 | 78.366 | 23.278 | 1.00 | 28.98 | | C |
| ANISOU | 545 | CB | SER | A | 112 | 4626 | 3451 | 2933 | 8 | −739 | −1316 | C |
| ATOM | 546 | OG | SER | A | 112 | −4.059 | 78.191 | 22.094 | 1.00 | 36.33 | | O |
| ANISOU | 546 | OG | SER | A | 112 | 5667 | 4402 | 3733 | −31 | −934 | −1430 | O |
| ATOM | 547 | N | SER | A | 113 | −4.839 | 76.280 | 25.242 | 1.00 | 28.52 | | N |
| ANISOU | 547 | N | SER | A | 113 | 4195 | 3160 | 3481 | −67 | −740 | −1391 | N |
| ATOM | 548 | CA | SER | A | 113 | −6.040 | 75.497 | 25.509 | 1.00 | 33.57 | | C |
| ANISOU | 548 | CA | SER | A | 113 | 4702 | 3713 | 4340 | −133 | −848 | −1462 | C |
| ATOM | 549 | C | SER | A | 113 | −7.049 | 76.237 | 26.395 | 1.00 | 30.95 | | C |
| ANISOU | 549 | C | SER | A | 113 | 4191 | 3405 | 4164 | −143 | −902 | −1359 | C |
| ATOM | 550 | O | SER | A | 113 | −6.860 | 76.342 | 27.606 | 1.00 | 32.01 | | O |
| ANISOU | 550 | O | SER | A | 113 | 4222 | 3527 | 4414 | −140 | −761 | −1250 | O |
| ATOM | 551 | CB | SER | A | 113 | −5.653 | 74.159 | 26.155 | 1.00 | 36.73 | | C |
| ANISOU | 551 | CB | SER | A | 113 | 5053 | 3983 | 4920 | −166 | −715 | −1498 | C |
| ATOM | 552 | OG | SER | A | 113 | −6.805 | 73.436 | 26.532 | 1.00 | 46.26 | | O |
| ANISOU | 552 | OG | SER | A | 113 | 6121 | 5099 | 6358 | −247 | −797 | −1544 | O |
| ATOM | 553 | N | ILE | A | 114 | −8.125 | 76.730 | 25.786 | 1.00 | 33.35 | | N |
| ANISOU | 553 | N | ILE | A | 114 | 4456 | 3741 | 4473 | −155 | −1110 | −1402 | N |
| ATOM | 554 | CA | ILE | A | 114 | −9.185 | 77.424 | 26.522 | 1.00 | 35.21 | | C |
| ANISOU | 554 | CA | ILE | A | 114 | 4498 | 3992 | 4889 | −158 | −1169 | −1338 | C |
| ATOM | 555 | C | ILE | A | 114 | −9.908 | 76.462 | 27.478 | 1.00 | 39.72 | | C |
| ANISOU | 555 | C | ILE | A | 114 | 4880 | 4474 | 5739 | −241 | −1099 | −1364 | C |
| ATOM | 556 | O | ILE | A | 114 | −10.214 | 75.329 | 27.102 | 1.00 | 31.42 | | O |
| ANISOU | 556 | O | ILE | A | 114 | 3827 | 3337 | 4774 | −309 | −1149 | −1476 | O |
| ATOM | 557 | CB | ILE | A | 114 | −10.221 | 78.048 | 25.568 | 1.00 | 41.40 | | C |
| ANISOU | 557 | CB | ILE | A | 114 | 5266 | 4810 | 5654 | −150 | −1441 | −1392 | C |
| ATOM | 558 | CG1 | ILE | A | 114 | −9.605 | 79.147 | 24.703 | 1.00 | 31.39 | | C |
| ANISOU | 558 | CG1 | ILE | A | 114 | 4187 | 3629 | 4110 | −79 | −1518 | −1328 | C |
| ATOM | 559 | CG2 | ILE | A | 114 | −11.413 | 78.592 | 26.344 | 1.00 | 45.98 | | C |
| ANISOU | 559 | CG2 | ILE | A | 114 | 5601 | 5384 | 6486 | −153 | −1497 | −1359 | C |
| ATOM | 560 | CD1 | ILE | A | 114 | −10.628 | 79.837 | 23.838 | 1.00 | 33.21 | | C |
| ANISOU | 560 | CD1 | ILE | A | 114 | 4407 | 3884 | 4327 | −64 | −1811 | −1349 | C |
| ATOM | 561 | N | LEU | A | 115 | −10.194 | 76.904 | 28.701 | 1.00 | 32.62 | | N |
| ANISOU | 561 | N | LEU | A | 115 | 3828 | 3590 | 4976 | −244 | −978 | −1265 | N |
| ATOM | 562 | CA | LEU | A | 115 | −10.851 | 76.031 | 29.668 | 1.00 | 29.61 | | C |
| ANISOU | 562 | CA | LEU | A | 115 | 3280 | 3134 | 4838 | −339 | −882 | −1269 | C |
| ATOM | 563 | C | LEU | A | 115 | −12.377 | 76.119 | 29.543 | 1.00 | 38.42 | | C |
| ANISOU | 563 | C | LEU | A | 115 | 4192 | 4237 | 6168 | −390 | −1031 | −1349 | C |
| ATOM | 564 | O | LEU | A | 115 | −12.969 | 77.126 | 29.925 | 1.00 | 36.42 | | O |
| ANISOU | 564 | O | LEU | A | 115 | 3811 | 4046 | 5982 | −353 | −1049 | −1314 | O |
| ATOM | 565 | CB | LEU | A | 115 | −10.396 | 76.380 | 31.091 | 1.00 | 28.07 | | C |
| ANISOU | 565 | CB | LEU | A | 115 | 3034 | 2970 | 4663 | −335 | −660 | −1130 | C |
| ATOM | 566 | CG | LEU | A | 115 | −10.885 | 75.522 | 32.269 | 1.00 | 39.49 | | C |
| ANISOU | 566 | CG | LEU | A | 115 | 4343 | 4351 | 6311 | −445 | −514 | −1091 | C |
| ATOM | 567 | CD1 | LEU | A | 115 | −10.471 | 74.046 | 32.127 | 1.00 | 35.31 | | C |
| ANISOU | 567 | CD1 | LEU | A | 115 | 3890 | 3693 | 5834 | −513 | −485 | −1118 | C |
| ATOM | 568 | CD2 | LEU | A | 115 | −10.414 | 76.084 | 33.602 | 1.00 | 27.20 | | C |
| ANISOU | 568 | CD2 | LEU | A | 115 | 2768 | 2855 | 4711 | −436 | −318 | −955 | C |
| ATOM | 569 | N | TYR | A | 116 | −13.000 | 75.058 | 29.012 | 1.00 | 35.99 | | N |
| ANISOU | 569 | N | TYR | A | 116 | 3843 | 3841 | 5989 | −476 | −1140 | −1467 | N |
| ATOM | 570 | CA | TYR | A | 116 | −14.442 | 75.029 | 28.741 | 1.00 | 36.28 | | C |
| ANISOU | 570 | CA | TYR | A | 116 | 3676 | 3856 | 6251 | −533 | −1313 | −1564 | C |
| ATOM | 571 | C | TYR | A | 116 | −15.241 | 74.384 | 29.883 | 1.00 | 41.67 | | C |
| ANISOU | 571 | C | TYR | A | 116 | 4132 | 4478 | 7221 | −651 | −1164 | −1548 | C |
| ATOM | 572 | O | TYR | A | 116 | −14.684 | 73.679 | 30.726 | 1.00 | 39.97 | | O |
| ANISOU | 572 | O | TYR | A | 116 | 3955 | 4211 | 7020 | −707 | −958 | −1472 | O |
| ATOM | 573 | CB | TYR | A | 116 | −14.734 | 74.277 | 27.427 | 1.00 | 36.97 | | C |
| ANISOU | 573 | CB | TYR | A | 116 | 3846 | 3885 | 6316 | −572 | −1546 | −1719 | C |
| ATOM | 574 | CG | TYR | A | 116 | −14.300 | 75.004 | 26.177 | 1.00 | 39.18 | | C |
| ANISOU | 574 | CG | TYR | A | 116 | 4325 | 4241 | 6320 | −478 | −1736 | −1749 | C |
| ATOM | 575 | CD1 | TYR | A | 116 | −15.039 | 76.075 | 25.678 | 1.00 | 43.33 | | C |
| ANISOU | 575 | CD1 | TYR | A | 116 | 4782 | 4835 | 6846 | −420 | −1950 | −1747 | C |
| ATOM | 576 | CD2 | TYR | A | 116 | −13.154 | 74.628 | 25.495 | 1.00 | 36.59 | | C |
| ANISOU | 576 | CD2 | TYR | A | 116 | 4252 | 3915 | 5737 | −450 | −1699 | −1775 | C |
| ATOM | 577 | CE1 | TYR | A | 116 | −14.637 | 76.751 | 24.537 | 1.00 | 38.30 | | C |
| ANISOU | 577 | CE1 | TYR | A | 116 | 4350 | 4265 | 5936 | −347 | −2128 | −1748 | C |
| ATOM | 578 | CE2 | TYR | A | 116 | −12.748 | 75.289 | 24.360 | 1.00 | 36.95 | | C |
| ANISOU | 578 | CE2 | TYR | A | 116 | 4493 | 4040 | 5507 | −382 | −1847 | −1794 | C |
| ATOM | 579 | CZ | TYR | A | 116 | −13.489 | 76.353 | 23.887 | 1.00 | 44.50 | | C |
| ANISOU | 579 | CZ | TYR | A | 116 | 5402 | 5064 | 6443 | −337 | −2066 | −1769 | C |
| ATOM | 580 | OH | TYR | A | 116 | −13.073 | 77.022 | 22.757 | 1.00 | 48.53 | | O |
| ANISOU | 580 | OH | TYR | A | 116 | 6131 | 5651 | 6658 | −282 | −2217 | −1763 | O |
| ATOM | 581 | N | CYS | A | 117 | −16.553 | 74.603 | 29.891 | 1.00 | 37.49 | | N |
| ANISOU | 581 | N | CYS | A | 117 | 3367 | 3951 | 6929 | −694 | −1273 | −1618 | N |
| ATOM | 582 | CA | CYS | A | 117 | −17.392 | 74.073 | 30.950 | 1.00 | 38.50 | | C |
| ANISOU | 582 | CA | CYS | A | 117 | 3261 | 4033 | 7335 | −819 | −1114 | −1608 | C |
| ATOM | 583 | C | CYS | A | 117 | −18.824 | 73.929 | 30.480 | 1.00 | 41.09 | | C |
| ANISOU | 583 | C | CYS | A | 117 | 3386 | 4343 | 7883 | −856 | −1274 | −1702 | C |
| ATOM | 584 | O | CYS | A | 117 | −19.098 | 73.948 | 29.284 | 1.00 | 42.32 | | O |
| ANISOU | 584 | O | CYS | A | 117 | 3611 | 4497 | 7971 | −805 | −1519 | −1777 | O |
| ATOM | 585 | CB | CYS | A | 117 | −17.327 | 74.968 | 32.198 | 1.00 | 37.28 | | C |
| ANISOU | 585 | CB | CYS | A | 117 | 3016 | 3968 | 7180 | −786 | −885 | −1494 | C |
| ATOM | 586 | SG | CYS | A | 117 | −17.755 | 76.757 | 31.952 | 1.00 | 41.85 | | S |
| ANISOU | 586 | SG | CYS | A | 117 | 3497 | 4663 | 7741 | −629 | −1011 | −1509 | S |
| ATOM | 587 | N | GLU | A | 118 | −19.722 | 73.761 | 31.446 | 1.00 | 53.28 | | N |
| ANISOU | 587 | N | GLU | A | 118 | 4714 | 5886 | 9646 | −933 | −1105 | −1671 | N |
| ATOM | 588 | C | GLU | A | 118 | −21.480 | 72.454 | 30.272 | 1.00 | 62.85 | | C |
| ANISOU | 588 | C | GLU | A | 118 | 5783 | 6992 | 11106 | −1027 | −1360 | −1813 | C |
| ATOM | 589 | O | GLU | A | 118 | −22.600 | 72.306 | 29.794 | 1.00 | 65.08 | | O |
| ANISOU | 589 | O | GLU | A | 118 | 5925 | 7258 | 11544 | −1041 | −1497 | −1882 | O |
| ATOM | 590 | CA | AGLU | A | 118 | −21.157 | 73.648 | 31.186 | 0.48 | 56.11 | | C |
| ANISOU | 590 | CA | AGLU | A | 118 | 4870 | 6234 | 10217 | −955 | −1200 | −1736 | C |
| ATOM | 591 | CB | AGLU | A | 118 | −21.689 | 74.953 | 30.586 | 0.48 | 54.91 | | C |
| ANISOU | 591 | CB | AGLU | A | 118 | 4643 | 6156 | 10066 | −812 | −1394 | −1772 | C |
| ATOM | 592 | CG | AGLU | A | 118 | −23.159 | 75.215 | 30.828 | 0.48 | 52.16 | | C |
| ANISOU | 592 | CG | AGLU | A | 118 | 4026 | 5810 | 9980 | −816 | −1400 | −1816 | C |
| ATOM | 593 | CD | AGLU | A | 118 | −23.870 | 75.531 | 29.547 | 0.48 | 49.86 | | C |
| ANISOU | 593 | CD | AGLU | A | 118 | 3720 | 5507 | 9716 | −737 | −1725 | −1889 | C |
| ATOM | 594 | OE1 | AGLU | A | 118 | −23.445 | 76.466 | 28.842 | 0.48 | 49.03 | | O |
| ANISOU | 594 | OE1 | AGLU | A | 118 | 3735 | 5443 | 9450 | −612 | −1905 | −1874 | O |
| ATOM | 595 | OE2 | AGLU | A | 118 | −24.831 | 74.812 | 29.226 | 0.48 | 53.89 | | O |
| ANISOU | 595 | OE2 | AGLU | A | 118 | 4113 | 5964 | 10399 | −808 | −1806 | −1953 | O |
| ATOM | 596 | CA | BGLU | A | 118 | −21.163 | 73.614 | 31.218 | 0.52 | 56.65 | | C |
| ANISOU | 596 | CA | BGLU | A | 118 | 4936 | 6300 | 10289 | −960 | −1193 | −1734 | C |
| ATOM | 597 | CB | BGLU | A | 118 | −21.761 | 74.929 | 30.706 | 0.52 | 54.47 | | C |
| ANISOU | 597 | CB | BGLU | A | 118 | 4566 | 6100 | 10032 | −821 | −1370 | −1770 | C |
| ATOM | 598 | CG | BGLU | A | 118 | −23.029 | 75.384 | 31.441 | 0.52 | 50.07 | | C |
| ANISOU | 598 | CG | BGLU | A | 118 | 3730 | 5567 | 9727 | −826 | −1264 | −1783 | C |
| ATOM | 599 | CD | BGLU | A | 118 | −23.144 | 74.848 | 32.868 | 0.52 | 47.29 | | C |
| ANISOU | 599 | CD | BGLU | A | 118 | 3277 | 5216 | 9477 | −953 | −924 | −1725 | C |
| ATOM | 600 | OE1 | BGLU | A | 118 | −22.210 | 74.983 | 33.691 | 0.52 | 45.20 | | O |
| ANISOU | 600 | OE1 | BGLU | A | 118 | 3108 | 4986 | 9080 | −971 | −722 | −1642 | O |
| ATOM | 601 | OE2 | BGLU | A | 118 | −24.197 | 74.267 | 33.161 | 0.52 | 49.66 | | O |
| ANISOU | 601 | OE2 | BGLU | A | 118 | 3406 | 5481 | 9982 | −1043 | −862 | −1757 | O |
| ATOM | 602 | N | ASN | A | 119 | −20.473 | 71.630 | 30.020 | 1.00 | 71.71 | | N |
| ANISOU | 602 | N | ASN | A | 119 | 7116 | 8047 | 12085 | −1065 | −1344 | −1809 | N |
| ATOM | 603 | CA | ASN | A | 119 | −20.673 | 70.282 | 29.543 | 1.00 | 86.75 | | C |
| ANISOU | 603 | CA | ASN | A | 119 | 9071 | 9837 | 14051 | −1162 | −1399 | −1868 | C |
| ATOM | 604 | C | ASN | A | 119 | −19.775 | 69.463 | 30.463 | 1.00 | 87.36 | | C |
| ANISOU | 604 | C | ASN | A | 119 | 9248 | 9833 | 14114 | −1246 | −1161 | −1776 | C |
| ATOM | 605 | O | ASN | A | 119 | −19.791 | 68.234 | 30.453 | 1.00 | 82.51 | | O |
| ANISOU | 605 | O | ASN | A | 119 | 8675 | 9097 | 13577 | −1344 | −1129 | −1786 | O |
| ATOM | 606 | CB | ASN | A | 119 | −20.325 | 70.120 | 28.058 | 1.00 | 103.78 | | C |
| ANISOU | 606 | CB | ASN | A | 119 | 11422 | 11985 | 16024 | −1101 | −1658 | −1975 | C |
| ATOM | 607 | CG | ASN | A | 119 | −21.488 | 69.561 | 27.238 | 1.00 | 108.44 | | C |
| ANISOU | 607 | CG | ASN | A | 119 | 11916 | 12537 | 16750 | −1150 | −1854 | −2080 | C |
| ATOM | 608 | OD1 | ASN | A | 119 | −22.280 | 68.744 | 27.723 | 1.00 | 105.76 | | O |
| ANISOU | 608 | OD1 | ASN | A | 119 | 11421 | 12123 | 16641 | −1265 | −1775 | −2085 | O |
| ATOM | 609 | ND2 | ASN | A | 119 | −21.599 | 70.011 | 25.992 | 1.00 | 110.25 | | N |
| ANISOU | 609 | ND2 | ASN | A | 119 | 12243 | 12819 | 16827 | −1071 | −2112 | −2157 | N |
| ATOM | 610 | N | GLU | A | 120 | −18.992 | 70.202 | 31.256 | 1.00 | 83.61 | | N |
| ANISOU | 610 | N | GLU | A | 120 | 8810 | 9418 | 13539 | −1202 | −1004 | −1680 | N |
| ATOM | 611 | CA | GLU | A | 120 | −18.190 | 69.702 | 32.377 | 1.00 | 78.42 | | C |
| ANISOU | 611 | CA | GLU | A | 120 | 8221 | 8705 | 12869 | −1275 | −755 | −1553 | C |
| ATOM | 612 | C | GLU | A | 120 | −18.217 | 70.777 | 33.472 | 1.00 | 77.06 | | C |
| ANISOU | 612 | C | GLU | A | 120 | 7937 | 8651 | 12690 | −1255 | −573 | −1459 | C |
| ATOM | 613 | O | GLU | A | 120 | −18.780 | 71.854 | 33.280 | 1.00 | 64.55 | | O |
| ANISOU | 613 | O | GLU | A | 120 | 6233 | 7174 | 11120 | −1173 | −649 | −1506 | O |
| ATOM | 614 | CB | GLU | A | 120 | −16.736 | 69.388 | 31.982 | 1.00 | 72.93 | | C |
| ANISOU | 614 | CB | GLU | A | 120 | 7782 | 7945 | 11985 | −1221 | −773 | −1550 | C |
| ATOM | 615 | CG | GLU | A | 120 | −16.523 | 69.056 | 30.525 | 1.00 | 79.16 | | C |
| ANISOU | 615 | CG | GLU | A | 120 | 8717 | 8699 | 12662 | −1157 | −1006 | −1693 | C |
| ATOM | 616 | CD | GLU | A | 120 | −16.522 | 70.299 | 29.665 | 1.00 | 85.32 | | C |
| ANISOU | 616 | CD | GLU | A | 120 | 9528 | 9612 | 13279 | −1030 | −1188 | −1761 | C |
| ATOM | 617 | OE1 | GLU | A | 120 | −15.937 | 71.300 | 30.114 | 1.00 | 87.64 | | O |
| ANISOU | 617 | OE1 | GLU | A | 120 | 9855 | 10000 | 13444 | −948 | −1105 | −1678 | O |
| ATOM | 618 | OE2 | GLU | A | 120 | −17.125 | 70.291 | 28.568 | 1.00 | 88.58 | | O |
| ANISOU | 618 | OE2 | GLU | A | 120 | 9949 | 10045 | 13662 | −1003 | −1403 | −1865 | O |
| ATOM | 619 | N | GLU | A | 121 | −17.626 | 70.477 | 34.621 | 1.00 | 82.12 | | N |
| ANISOU | 619 | N | GLU | A | 121 | 8625 | 9270 | 13307 | −1328 | −334 | −1323 | N |
| ATOM | 620 | CA | GLU | A | 121 | −17.628 | 71.401 | 35.743 | 1.00 | 80.47 | | C |
| ANISOU | 620 | CA | GLU | A | 121 | 8333 | 9180 | 13061 | −1323 | −131 | −1232 | C |
| ATOM | 621 | C | GLU | A | 121 | −16.376 | 72.261 | 35.711 | 1.00 | 76.19 | | C |
| ANISOU | 621 | C | GLU | A | 121 | 8007 | 8731 | 12210 | −1157 | −122 | −1155 | C |
| ATOM | 622 | O | GLU | A | 121 | −15.324 | 71.799 | 35.273 | 1.00 | 74.12 | | O |
| ANISOU | 622 | O | GLU | A | 121 | 7959 | 8410 | 11792 | −1105 | −174 | −1122 | O |
| ATOM | 623 | CB | GLU | A | 121 | −17.692 | 70.636 | 37.043 | 1.00 | 84.84 | | C |
| ANISOU | 623 | CB | GLU | A | 121 | 8882 | 9698 | 13655 | −1467 | 128 | −1083 | C |
| ATOM | 624 | CG | GLU | A | 121 | −18.911 | 69.780 | 37.152 | 1.00 | 94.23 | | C |
| ANISOU | 624 | CG | GLU | A | 121 | 9933 | 10833 | 15036 | −1582 | 147 | −1101 | C |
| ATOM | 625 | CD | GLU | A | 121 | −19.051 | 69.213 | 38.523 | 1.00 | 103.27 | | C |
| ANISOU | 625 | CD | GLU | A | 121 | 11078 | 11975 | 16184 | −1724 | 411 | −941 | C |
| ATOM | 626 | OE1 | GLU | A | 121 | −18.085 | 69.325 | 39.312 | 1.00 | 102.85 | | O |
| ANISOU | 626 | OE1 | GLU | A | 121 | 11168 | 11940 | 15969 | −1732 | 554 | −805 | O |
| ATOM | 627 | OE2 | GLU | A | 121 | −20.092 | 68.584 | 38.789 | 1.00 | 111.20 | | O |
| ANISOU | 627 | OE2 | GLU | A | 121 | 11958 | 12951 | 17343 | −1835 | 464 | −942 | O |
| ATOM | 628 | N | CYS | A | 122 | −16.479 | 73.488 | 36.209 | 1.00 | 71.52 | | N |
| ANISOU | 628 | N | CYS | A | 122 | 7351 | 8275 | 11548 | −1080 | −46 | −1134 | N |
| ATOM | 629 | CA | CYS | A | 122 | −15.316 | 74.354 | 36.348 | 1.00 | 57.76 | | C |
| ANISOU | 629 | CA | CYS | A | 122 | 5795 | 6618 | 9531 | −943 | −13 | −1051 | C |
| ATOM | 630 | C | CYS | A | 122 | −14.551 | 74.038 | 37.616 | 1.00 | 53.93 | | C |
| ANISOU | 630 | C | CYS | A | 122 | 5419 | 6144 | 8927 | −1001 | 219 | −891 | C |
| ATOM | 631 | O | CYS | A | 122 | −15.057 | 74.241 | 38.719 | 1.00 | 65.44 | | O |
| ANISOU | 631 | O | CYS | A | 122 | 6766 | 7660 | 10437 | −1084 | 410 | −844 | O |
| ATOM | 632 | CB | CYS | A | 122 | −15.732 | 75.812 | 36.357 | 1.00 | 50.02 | | C |
| ANISOU | 632 | CB | CYS | A | 122 | 4707 | 5758 | 8540 | −836 | −41 | −1101 | C |
| ATOM | 633 | SG | CYS | A | 122 | −15.597 | 76.539 | 34.764 | 1.00 | 42.33 | | S |
| ANISOU | 633 | SG | CYS | A | 122 | 3807 | 4793 | 7482 | −683 | −348 | −1197 | S |
| ATOM | 634 | N | PRO | A | 123 | −13.329 | 73.525 | 37.461 | 1.00 | 39.65 | | N |
| ANISOU | 634 | N | PRO | A | 123 | 3828 | 4280 | 6958 | −961 | 203 | −809 | N |
| ATOM | 635 | CA | PRO | A | 123 | −12.407 | 73.317 | 38.583 | 1.00 | 34.55 | | C |
| ANISOU | 635 | CA | PRO | A | 123 | 3313 | 3645 | 6170 | −989 | 375 | −643 | C |
| ATOM | 636 | C | PRO | A | 123 | −12.142 | 74.622 | 39.321 | 1.00 | 29.92 | | C |
| ANISOU | 636 | C | PRO | A | 123 | 2730 | 3211 | 5427 | −919 | 477 | −601 | C |
| ATOM | 637 | O | PRO | A | 123 | −12.394 | 75.698 | 38.774 | 1.00 | 39.35 | | O |
| ANISOU | 637 | O | PRO | A | 123 | 3865 | 4482 | 6603 | −815 | 391 | −694 | O |
| ATOM | 638 | CB | PRO | A | 123 | −11.140 | 72.804 | 37.901 | 1.00 | 34.22 | | C |
| ANISOU | 638 | CB | PRO | A | 123 | 3473 | 3523 | 6008 | −904 | 274 | −615 | C |
| ATOM | 639 | CG | PRO | A | 123 | −11.210 | 73.381 | 36.538 | 1.00 | 33.70 | | C |
| ANISOU | 639 | CG | PRO | A | 123 | 3411 | 3483 | 5909 | −791 | 86 | −759 | C |
| ATOM | 640 | CD | PRO | A | 123 | −12.659 | 73.343 | 36.165 | 1.00 | 35.32 | | C |
| ANISOU | 640 | CD | PRO | A | 123 | 3418 | 3679 | 6325 | −861 | 11 | −880 | C |
| ATOM | 641 | N | PHE | A | 124 | −11.679 | 74.519 | 40.561 | 1.00 | 30.27 | | N |
| ANISOU | 641 | N | PHE | A | 124 | 2844 | 3291 | 5366 | −981 | 650 | −462 | N |
| ATOM | 642 | CA | PHE | A | 124 | −11.305 | 75.679 | 41.353 | 1.00 | 31.17 | | C |
| ANISOU | 642 | CA | PHE | A | 124 | 2989 | 3543 | 5313 | −925 | 752 | −426 | C |
| ATOM | 643 | C | PHE | A | 124 | −12.479 | 76.596 | 41.641 | 1.00 | 30.46 | | C |
| ANISOU | 643 | C | PHE | A | 124 | 2699 | 3550 | 5326 | −938 | 829 | −537 | C |
| ATOM | 644 | O | PHE | A | 124 | −12.279 | 77.775 | 41.889 | 1.00 | 32.47 | | O |
| ANISOU | 644 | O | PHE | A | 124 | 2955 | 3903 | 5479 | −850 | 855 | −569 | O |
| ATOM | 645 | CB | PHE | A | 124 | −10.191 | 76.470 | 40.662 | 1.00 | 34.15 | | C |
| ANISOU | 645 | CB | PHE | A | 124 | 3499 | 3952 | 5524 | −760 | 625 | −435 | C |
| ATOM | 646 | CG | PHE | A | 124 | −9.069 | 75.613 | 40.158 | 1.00 | 34.04 | | C |
| ANISOU | 646 | CG | PHE | A | 124 | 3648 | 3839 | 5447 | −725 | 540 | −367 | C |
| ATOM | 647 | CD1 | PHE | A | 124 | −8.364 | 74.801 | 41.030 | 1.00 | 32.46 | | C |
| ANISOU | 647 | CD1 | PHE | A | 124 | 3555 | 3587 | 5190 | −792 | 623 | −218 | C |
| ATOM | 648 | CD2 | PHE | A | 124 | −8.707 | 75.632 | 38.828 | 1.00 | 25.43 | | C |
| ANISOU | 648 | CD2 | PHE | A | 124 | 2607 | 2704 | 4351 | −625 | 377 | −452 | C |
| ATOM | 649 | CE1 | PHE | A | 124 | −7.331 | 74.008 | 40.589 | 1.00 | 25.90 | | C |
| ANISOU | 649 | CE1 | PHE | A | 124 | 2852 | 2651 | 4340 | −748 | 544 | −166 | C |
| ATOM | 650 | CE2 | PHE | A | 124 | −7.666 | 74.854 | 38.378 | 1.00 | 27.04 | | C |
| ANISOU | 650 | CE2 | PHE | A | 124 | 2946 | 2817 | 4509 | −589 | 324 | −413 | C |
| ATOM | 651 | CZ | PHE | A | 124 | −6.972 | 74.037 | 39.266 | 1.00 | 28.13 | | C |
| ANISOU | 651 | CZ | PHE | A | 124 | 3165 | 2892 | 4630 | −644 | 407 | −274 | C |
| ATOM | 652 | N | LYS | A | 125 | −13.691 | 76.054 | 41.590 | 1.00 | 37.58 | | N |
| ANISOU | 652 | N | LYS | A | 125 | 3418 | 4411 | 6452 | −1046 | 863 | −606 | N |
| ATOM | 653 | CA | LYS | A | 125 | −14.887 | 76.824 | 41.922 | 1.00 | 44.74 | | C |
| ANISOU | 653 | CA | LYS | A | 125 | 4094 | 5398 | 7505 | −1067 | 955 | −723 | C |
| ATOM | 654 | C | LYS | A | 125 | −15.069 | 78.093 | 41.077 | 1.00 | 38.96 | | C |
| ANISOU | 654 | C | LYS | A | 125 | 3289 | 4712 | 6804 | −898 | 795 | −852 | C |
| ATOM | 655 | O | LYS | A | 125 | −15.523 | 79.114 | 41.563 | 1.00 | 40.96 | | O |
| ANISOU | 655 | O | LYS | A | 125 | 3427 | 5051 | 7086 | −857 | 884 | −922 | O |
| ATOM | 656 | CB | LYS | A | 125 | −14.832 | 77.195 | 43.401 | 1.00 | 49.03 | | C |
| ANISOU | 656 | CB | LYS | A | 125 | 4656 | 6051 | 7921 | −1146 | 1216 | −656 | C |
| ATOM | 657 | CG | LYS | A | 125 | −15.089 | 76.006 | 44.294 | 1.00 | 56.36 | | C |
| ANISOU | 657 | CG | LYS | A | 125 | 5600 | 6942 | 8873 | −1347 | 1394 | −539 | C |
| ATOM | 658 | CD | LYS | A | 125 | −14.967 | 76.358 | 45.762 | 1.00 | 56.83 | | C |
| ANISOU | 658 | CD | LYS | A | 125 | 5718 | 7123 | 8750 | −1436 | 1650 | −463 | C |
| ATOM | 659 | CE | LYS | A | 125 | −15.679 | 75.315 | 46.601 | 1.00 | 64.97 | | C |
| ANISOU | 659 | CE | LYS | A | 125 | 6744 | 8136 | 9805 | −1607 | 1790 | −362 | C |
| ATOM | 660 | NZ | LYS | A | 125 | −15.988 | 74.089 | 45.799 | 1.00 | 70.05 | | N |
| ANISOU | 660 | NZ | LYS | A | 125 | 7340 | 8617 | 10658 | −1678 | 1670 | −339 | N |
| ATOM | 661 | N | LEU | A | 126 | −14.695 | 78.025 | 39.809 | 1.00 | 38.60 | | N |
| ANISOU | 661 | N | LEU | A | 126 | 3319 | 4601 | 6745 | −800 | 558 | −881 | N |
| ATOM | 662 | CA | LEU | A | 126 | −14.815 | 79.169 | 38.928 | 1.00 | 33.60 | | C |
| ANISOU | 662 | CA | LEU | A | 126 | 2649 | 3996 | 6123 | −648 | 380 | −973 | C |
| ATOM | 663 | C | LEU | A | 126 | −16.207 | 79.235 | 38.347 | 1.00 | 35.42 | | C |
| ANISOU | 663 | C | LEU | A | 126 | 2629 | 4197 | 6632 | −660 | 267 | −1111 | C |
| ATOM | 664 | O | LEU | A | 126 | −16.909 | 78.224 | 38.286 | 1.00 | 34.15 | | O |
| ANISOU | 664 | O | LEU | A | 126 | 2357 | 3975 | 6643 | −780 | 274 | −1141 | O |
| ATOM | 665 | CB | LEU | A | 126 | −13.775 | 79.101 | 37.813 | 1.00 | 29.14 | | C |
| ANISOU | 665 | CB | LEU | A | 126 | 2293 | 3387 | 5390 | −549 | 186 | −938 | C |
| ATOM | 666 | CG | LEU | A | 126 | −12.345 | 79.071 | 38.339 | 1.00 | 27.35 | | C |
| ANISOU | 666 | CG | LEU | A | 126 | 2289 | 3185 | 4917 | −527 | 282 | −809 | C |
| ATOM | 667 | CD1 | LEU | A | 126 | −11.340 | 78.709 | 37.241 | 1.00 | 26.24 | | C |
| ANISOU | 667 | CD1 | LEU | A | 126 | 2335 | 2990 | 4643 | −457 | 128 | −786 | C |
| ATOM | 668 | CD2 | LEU | A | 126 | −12.015 | 80.395 | 38.959 | 1.00 | 26.49 | | C |
| ANISOU | 668 | CD2 | LEU | A | 126 | 2193 | 3169 | 4702 | −448 | 359 | −796 | C |
| ATOM | 669 | N | ASN | A | 127 | −16.631 | 80.434 | 37.963 | 1.00 | 32.82 | | N |
| ANISOU | 669 | N | ASN | A | 127 | 2198 | 3902 | 6371 | −538 | 159 | −1193 | N |
| ATOM | 670 | CA | ASN | A | 127 | −17.890 | 80.565 | 37.261 | 1.00 | 36.70 | | C |
| ANISOU | 670 | CA | ASN | A | 127 | 2452 | 4357 | 7137 | −524 | −7 | −1322 | C |
| ATOM | 671 | C | ASN | A | 127 | −17.796 | 80.061 | 35.833 | 1.00 | 34.80 | | C |
| ANISOU | 671 | C | ASN | A | 127 | 2302 | 4042 | 6878 | −493 | −297 | −1343 | C |
| ATOM | 672 | O | ASN | A | 127 | −16.727 | 80.048 | 35.225 | 1.00 | 33.16 | | O |
| ANISOU | 672 | O | ASN | A | 127 | 2342 | 3827 | 6432 | −432 | −390 | −1274 | O |
| ATOM | 673 | CB | ASN | A | 127 | −18.372 | 82.009 | 37.271 | 1.00 | 39.57 | | C |
| ANISOU | 673 | CB | ASN | A | 127 | 2677 | 4758 | 7601 | −392 | −58 | −1399 | C |
| ATOM | 674 | CG | ASN | A | 127 | −18.650 | 82.505 | 38.660 | 1.00 | 42.28 | | C |
| ANISOU | 674 | CG | ASN | A | 127 | 2898 | 5175 | 7993 | −429 | 236 | −1425 | C |
| ATOM | 675 | OD1 | ASN | A | 127 | −19.081 | 81.744 | 39.528 | 1.00 | 40.43 | | O |
| ANISOU | 675 | OD1 | ASN | A | 127 | 2591 | 4960 | 7812 | −570 | 454 | −1419 | O |
| ATOM | 676 | ND2 | ASN | A | 127 | −18.419 | 83.781 | 38.882 | 1.00 | 35.24 | | N |
| ANISOU | 676 | ND2 | ASN | A | 127 | 2017 | 4318 | 7056 | −305 | 245 | −1449 | N |
| ATOM | 677 | N | CYS | A | 128 | −18.936 | 79.653 | 35.310 | 1.00 | 36.90 | | N |
| ANISOU | 677 | N | CYS | A | 128 | 2360 | 4258 | 7402 | −543 | −435 | −1448 | N |
| ATOM | 678 | CA | CYS | A | 128 | −19.043 | 79.244 | 33.932 | 1.00 | 37.48 | | C |
| ANISOU | 678 | CA | CYS | A | 128 | 2497 | 4268 | 7475 | −520 | −735 | −1498 | C |
| ATOM | 679 | C | CYS | A | 128 | −19.978 | 80.169 | 33.149 | 1.00 | 41.05 | | C |
| ANISOU | 679 | C | CYS | A | 128 | 2805 | 4717 | 8077 | −407 | −984 | −1578 | C |
| ATOM | 680 | O | CYS | A | 128 | −21.197 | 80.120 | 33.328 | 1.00 | 41.25 | | O |
| ANISOU | 680 | O | CYS | A | 128 | 2642 | 4721 | 8312 | −422 | −966 | −1630 | O |
| ATOM | 681 | CB | CYS | A | 128 | −19.550 | 77.803 | 33.870 | 1.00 | 38.91 | | C |
| ANISOU | 681 | CB | CYS | A | 128 | 2609 | 4372 | 7804 | −678 | −722 | −1538 | C |
| ATOM | 682 | SG | CYS | A | 128 | −19.728 | 77.232 | 32.210 | 1.00 | 43.62 | | S |
| ANISOU | 682 | SG | CYS | A | 128 | 3317 | 4896 | 8361 | −652 | −1072 | −1611 | S |
| ATOM | 683 | N | VAL | A | 129 | −19.415 | 81.047 | 32.324 | 1.00 | 45.31 | | N |
| ANISOU | 683 | N | VAL | A | 129 | 3485 | 5271 | 8461 | −279 | −1192 | −1555 | N |
| ATOM | 684 | CA | VAL | A | 129 | −20.252 | 81.953 | 31.542 | 1.00 | 39.85 | | C |
| ANISOU | 684 | CA | VAL | A | 129 | 2720 | 4558 | 7865 | −158 | −1435 | −1586 | C |
| ATOM | 685 | C | VAL | A | 129 | −19.960 | 81.798 | 30.048 | 1.00 | 40.17 | | C |
| ANISOU | 685 | C | VAL | A | 129 | 2961 | 4572 | 7730 | −120 | −1753 | −1578 | C |
| ATOM | 686 | O | VAL | A | 129 | −18.800 | 81.814 | 29.606 | 1.00 | 38.44 | | O |
| ANISOU | 686 | O | VAL | A | 129 | 2977 | 4377 | 7250 | −103 | −1803 | −1529 | O |
| ATOM | 687 | CB | VAL | A | 129 | −20.140 | 83.460 | 32.025 | 1.00 | 50.82 | | C |
| ANISOU | 687 | CB | VAL | A | 129 | 4063 | 5976 | 9268 | −24 | −1388 | −1556 | C |
| ATOM | 688 | CG1 | VAL | A | 129 | −19.364 | 83.562 | 33.302 | 1.00 | 37.38 | | C |
| ANISOU | 688 | CG1 | VAL | A | 129 | 2374 | 4337 | 7493 | −62 | −1070 | −1520 | C |
| ATOM | 689 | CG2 | VAL | A | 129 | −19.612 | 84.413 | 30.945 | 1.00 | 38.87 | | C |
| ANISOU | 689 | CG2 | VAL | A | 129 | 2730 | 4452 | 7587 | 108 | −1665 | −1497 | C |
| ATOM | 690 | N | LYS | A | 130 | −21.048 | 81.588 | 29.306 | 1.00 | 42.67 | | N |
| ANISOU | 690 | N | LYS | A | 130 | 3195 | 4841 | 8175 | −115 | −1944 | −1628 | N |
| ATOM | 691 | CA | LYS | A | 130 | −21.034 | 81.313 | 27.877 | 1.00 | 43.75 | | C |
| ANISOU | 691 | CA | LYS | A | 130 | 3508 | 4956 | 8157 | −100 | −2237 | −1633 | C |
| ATOM | 692 | C | LYS | A | 130 | −20.048 | 80.193 | 27.536 | 1.00 | 47.63 | | C |
| ANISOU | 692 | C | LYS | A | 130 | 4212 | 5454 | 8432 | −196 | −2206 | −1646 | C |
| ATOM | 693 | O | LYS | A | 130 | −19.270 | 80.287 | 26.589 | 1.00 | 48.08 | | O |
| ANISOU | 693 | O | LYS | A | 130 | 4519 | 5531 | 8218 | −162 | −2355 | −1620 | O |
| ATOM | 694 | CB | LYS | A | 130 | −20.739 | 82.591 | 27.083 | 1.00 | 43.75 | | C |
| ANISOU | 694 | CB | LYS | A | 130 | 3654 | 4970 | 8001 | 38 | −2453 | −1557 | C |
| ATOM | 695 | CG | LYS | A | 130 | −21.868 | 83.602 | 27.228 | 1.00 | 63.65 | | C |
| ANISOU | 695 | CG | LYS | A | 130 | 5970 | 7447 | 10769 | 132 | −2528 | −1560 | C |
| ATOM | 696 | CD | LYS | A | 130 | −21.697 | 84.884 | 26.421 | 1.00 | 67.37 | | C |
| ANISOU | 696 | CD | LYS | A | 130 | 6582 | 7900 | 11117 | 263 | −2755 | −1469 | C |
| ATOM | 697 | CE | LYS | A | 130 | −20.307 | 85.477 | 26.499 | 1.00 | 70.03 | | C |
| ANISOU | 697 | CE | LYS | A | 130 | 7140 | 8284 | 11185 | 307 | −2694 | −1374 | C |
| ATOM | 698 | NZ | LYS | A | 130 | −20.149 | 86.525 | 25.443 | 1.00 | 71.89 | | N |
| ANISOU | 698 | NZ | LYS | A | 130 | 7565 | 8494 | 11257 | 404 | −2946 | −1267 | N |
| ATOM | 699 | N | GLY | A | 131 | −20.071 | 79.144 | 28.351 | 1.00 | 42.11 | | N |
| ANISOU | 699 | N | GLY | A | 131 | 3420 | 4729 | 7849 | −317 | −1989 | −1682 | N |
| ATOM | 700 | CA | GLY | A | 131 | −19.316 | 77.944 | 28.062 | 1.00 | 41.43 | | C |
| ANISOU | 700 | CA | GLY | A | 131 | 3509 | 4611 | 7621 | −413 | −1953 | −1710 | C |
| ATOM | 701 | C | GLY | A | 131 | −17.852 | 77.934 | 28.429 | 1.00 | 42.18 | | C |
| ANISOU | 701 | C | GLY | A | 131 | 3806 | 4729 | 7490 | −410 | −1797 | −1652 | C |
| ATOM | 702 | O | GLY | A | 131 | −17.200 | 76.913 | 28.231 | 1.00 | 44.91 | | O |
| ANISOU | 702 | O | GLY | A | 131 | 4310 | 5032 | 7721 | −474 | −1734 | −1668 | O |
| ATOM | 703 | N | LYS | A | 132 | −17.321 | 79.051 | 28.933 | 1.00 | 37.15 | | N |
| ANISOU | 703 | N | LYS | A | 132 | 3214 | 4158 | 6744 | −308 | −1686 | −1548 | N |
| ATOM | 704 | CA | LYS | A | 132 | −15.909 | 79.113 | 29.334 | 1.00 | 34.72 | | C |
| ANISOU | 704 | CA | LYS | A | 132 | 3137 | 3885 | 6172 | −277 | −1477 | −1438 | C |
| ATOM | 705 | C | LYS | A | 132 | −15.793 | 79.367 | 30.831 | 1.00 | 39.77 | | C |
| ANISOU | 705 | C | LYS | A | 132 | 3662 | 4552 | 6898 | −294 | −1187 | −1364 | C |
| ATOM | 706 | O | LYS | A | 132 | −16.668 | 80.007 | 31.418 | 1.00 | 40.27 | | O |
| ANISOU | 706 | O | LYS | A | 132 | 3504 | 4633 | 7163 | −280 | −1160 | −1387 | O |
| ATOM | 707 | CB | LYS | A | 132 | −15.164 | 80.218 | 28.579 | 1.00 | 37.40 | | C |
| ANISOU | 707 | CB | LYS | A | 132 | 3676 | 4278 | 6254 | −154 | −1595 | −1370 | C |
| ATOM | 708 | CG | LYS | A | 132 | −15.206 | 80.097 | 27.068 | 1.00 | 44.04 | | C |
| ANISOU | 708 | CG | LYS | A | 132 | 4673 | 5113 | 6946 | −140 | −1880 | −1428 | C |
| ATOM | 709 | CD | LYS | A | 132 | −14.510 | 81.279 | 26.387 | 1.00 | 37.90 | | C |
| ANISOU | 709 | CD | LYS | A | 132 | 4094 | 4390 | 5914 | −33 | −1979 | −1335 | C |
| ATOM | 710 | CE | LYS | A | 132 | −14.717 | 81.248 | 24.874 | 1.00 | 42.06 | | C |
| ANISOU | 710 | CE | LYS | A | 132 | 4776 | 4923 | 6280 | −28 | −2285 | −1387 | C |
| ATOM | 711 | NZ | LYS | A | 132 | −16.144 | 81.531 | 24.503 | 1.00 | 55.13 | | N |
| ANISOU | 711 | NZ | LYS | A | 132 | 6227 | 6546 | 8173 | −20 | −2571 | −1453 | N |
| ATOM | 712 | N | CYS | A | 133 | −14.712 | 78.896 | 31.445 | 1.00 | 31.85 | | N |
| ANISOU | 712 | N | CYS | A | 133 | 2808 | 3552 | 5740 | −320 | −976 | −1281 | N |
| ATOM | 713 | CA | CYS | A | 133 | −14.474 | 79.182 | 32.846 | 1.00 | 30.80 | | C |
| ANISOU | 713 | CA | CYS | A | 133 | 2613 | 3458 | 5630 | −338 | −716 | −1200 | C |
| ATOM | 714 | C | CYS | A | 133 | −14.054 | 80.647 | 32.969 | 1.00 | 39.29 | | C |
| ANISOU | 714 | C | CYS | A | 133 | 3735 | 4604 | 6589 | −215 | −716 | −1146 | C |
| ATOM | 715 | O | CYS | A | 133 | −13.093 | 81.099 | 32.335 | 1.00 | 32.45 | | O |
| ANISOU | 715 | O | CYS | A | 133 | 3069 | 3757 | 5502 | −138 | −783 | −1094 | O |
| ATOM | 716 | CB | CYS | A | 133 | −13.418 | 78.242 | 33.428 | 1.00 | 29.58 | | C |
| ANISOU | 716 | CB | CYS | A | 133 | 2612 | 3278 | 5350 | −399 | −532 | −1116 | C |
| ATOM | 717 | SG | CYS | A | 133 | −14.003 | 76.476 | 33.503 | 1.00 | 40.12 | | S |
| ANISOU | 717 | SG | CYS | A | 133 | 3870 | 4495 | 6878 | −561 | −506 | −1168 | S |
| ATOM | 718 | N | GLU | A | 134 | −14.798 | 81.393 | 33.774 | 1.00 | 36.38 | | N |
| ANISOU | 718 | N | GLU | A | 134 | 3173 | 4267 | 6381 | −202 | −634 | −1168 | N |
| ATOM | 719 | CA | GLU | A | 134 | −14.654 | 82.842 | 33.813 | 1.00 | 36.33 | | C |
| ANISOU | 719 | CA | GLU | A | 134 | 3172 | 4301 | 6331 | −82 | −671 | −1147 | C |
| ATOM | 720 | C | GLU | A | 134 | −13.427 | 83.316 | 34.591 | 1.00 | 33.64 | | C |
| ANISOU | 720 | C | GLU | A | 134 | 2991 | 4009 | 5780 | −54 | −485 | −1046 | C |
| ATOM | 721 | O | GLU | A | 134 | −13.224 | 82.927 | 35.740 | 1.00 | 37.44 | | O |
| ANISOU | 721 | O | GLU | A | 134 | 3450 | 4519 | 6255 | −126 | −261 | −1015 | O |
| ATOM | 722 | CB | GLU | A | 134 | −15.919 | 83.459 | 34.415 | 1.00 | 31.36 | | C |
| ANISOU | 722 | CB | GLU | A | 134 | 2259 | 3677 | 5981 | −71 | −639 | −1235 | C |
| ATOM | 723 | CG | GLU | A | 134 | −15.918 | 84.960 | 34.362 | 1.00 | 47.32 | | C |
| ANISOU | 723 | CG | GLU | A | 134 | 4261 | 5706 | 8011 | 63 | −711 | −1233 | C |
| ATOM | 724 | CD | GLU | A | 134 | −17.047 | 85.582 | 35.141 | 1.00 | 55.38 | | C |
| ANISOU | 724 | CD | GLU | A | 134 | 4996 | 6731 | 9317 | 81 | −625 | −1336 | C |
| ATOM | 725 | OE1 | GLU | A | 134 | −17.493 | 84.997 | 36.148 | 1.00 | 58.38 | | O |
| ANISOU | 725 | OE1 | GLU | A | 134 | 5235 | 7143 | 9806 | −23 | −396 | −1380 | O |
| ATOM | 726 | OE2 | GLU | A | 134 | −17.490 | 86.671 | 34.740 | 1.00 | 63.99 | | O |
| ANISOU | 726 | OE2 | GLU | A | 134 | 6001 | 7786 | 10527 | 199 | −784 | −1372 | O |
| ATOM | 727 | N | TYR | A | 135 | −12.613 | 84.166 | 33.972 | 1.00 | 30.48 | | N |
| ANISOU | 727 | N | TYR | A | 135 | 2757 | 3618 | 5206 | 42 | −583 | −989 | N |
| ATOM | 728 | CA | TYR | A | 135 | −11.602 | 84.897 | 34.731 | 1.00 | 25.22 | | C |
| ANISOU | 728 | CA | TYR | A | 135 | 2197 | 2995 | 4389 | 79 | −432 | −912 | C |
| ATOM | 729 | C | TYR | A | 135 | −12.210 | 86.217 | 35.208 | 1.00 | 35.20 | | C |
| ANISOU | 729 | C | TYR | A | 135 | 3324 | 4265 | 5785 | 153 | −429 | −955 | C |
| ATOM | 730 | O | TYR | A | 135 | −12.856 | 86.914 | 34.426 | 1.00 | 31.58 | | O |
| ANISOU | 730 | O | TYR | A | 135 | 2800 | 3765 | 5432 | 230 | −625 | −992 | O |
| ATOM | 731 | CB | TYR | A | 135 | −10.337 | 85.178 | 33.903 | 1.00 | 23.96 | | C |
| ANISOU | 731 | CB | TYR | A | 135 | 2277 | 2838 | 3989 | 132 | −509 | −827 | C |
| ATOM | 732 | CG | TYR | A | 135 | −9.355 | 86.076 | 34.662 | 1.00 | 29.03 | | C |
| ANISOU | 732 | CG | TYR | A | 135 | 3003 | 3516 | 4510 | 170 | −378 | −756 | C |
| ATOM | 733 | CD1 | TYR | A | 135 | −8.614 | 85.577 | 35.734 | 1.00 | 24.80 | | C |
| ANISOU | 733 | CD1 | TYR | A | 135 | 2509 | 3017 | 3897 | 111 | −180 | −709 | C |
| ATOM | 734 | CD2 | TYR | A | 135 | −9.201 | 87.424 | 34.332 | 1.00 | 29.20 | | C |
| ANISOU | 734 | CD2 | TYR | A | 135 | 3061 | 3527 | 4508 | 259 | −468 | −733 | C |
| ATOM | 735 | CE1 | TYR | A | 135 | −7.735 | 86.389 | 36.453 | 1.00 | 22.02 | | C |
| ANISOU | 735 | CE1 | TYR | A | 135 | 2227 | 2699 | 3440 | 138 | −79 | −655 | C |
| ATOM | 736 | CE2 | TYR | A | 135 | −8.322 | 88.257 | 35.050 | 1.00 | 24.65 | | C |
| ANISOU | 736 | CE2 | TYR | A | 135 | 2552 | 2973 | 3840 | 284 | −354 | −681 | C |
| ATOM | 737 | CZ | TYR | A | 135 | −7.594 | 87.726 | 36.110 | 1.00 | 28.68 | | C |
| ANISOU | 737 | CZ | TYR | A | 135 | 3097 | 3530 | 4269 | 222 | −162 | −649 | C |
| ATOM | 738 | OH | TYR | A | 135 | −6.723 | 88.521 | 36.825 | 1.00 | 34.17 | | O |
| ANISOU | 738 | OH | TYR | A | 135 | 3858 | 4250 | 4874 | 239 | −69 | −607 | O |
| ATOM | 739 | N | MET | A | 136 | −12.007 | 86.557 | 36.479 | 1.00 | 35.01 | | N |
| ANISOU | 739 | N | MET | A | 136 | 3261 | 4285 | 5757 | 132 | −216 | −954 | N |
| ATOM | 740 | CA | MET | A | 136 | −12.387 | 87.880 | 36.985 | 1.00 | 39.60 | | C |
| ANISOU | 740 | CA | MET | A | 136 | 3739 | 4865 | 6443 | 210 | −189 | −1009 | C |
| ATOM | 741 | C | MET | A | 136 | −11.556 | 88.309 | 38.192 | 1.00 | 35.75 | | C |
| ANISOU | 741 | C | MET | A | 136 | 3330 | 4433 | 5820 | 190 | 23 | −979 | C |
| ATOM | 742 | O | MET | A | 136 | −11.170 | 87.491 | 39.034 | 1.00 | 32.54 | | O |
| ANISOU | 742 | O | MET | A | 136 | 2967 | 4080 | 5316 | 92 | 196 | −944 | O |
| ATOM | 743 | CB | MET | A | 136 | −13.875 | 87.941 | 37.342 | 1.00 | 46.72 | | C |
| ANISOU | 743 | CB | MET | A | 136 | 4361 | 5754 | 7635 | 202 | −166 | −1140 | C |
| ATOM | 744 | CG | MET | A | 136 | −14.327 | 86.981 | 38.426 | 1.00 | 59.40 | | C |
| ANISOU | 744 | CG | MET | A | 136 | 5855 | 7415 | 9300 | 70 | 72 | −1180 | C |
| ATOM | 745 | SD | MET | A | 136 | −16.126 | 87.013 | 38.619 | 1.00 | 108.59 | | S |
| ANISOU | 745 | SD | MET | A | 136 | 11726 | 13626 | 15907 | 56 | 87 | −1344 | S |
| ATOM | 746 | CE | MET | A | 136 | −16.315 | 85.994 | 40.077 | 1.00 | 94.69 | | C |
| ANISOU | 746 | CE | MET | A | 136 | 9906 | 11948 | 14124 | −124 | 432 | −1351 | C |
| ATOM | 747 | N | GLN | A | 137 | −11.270 | 89.608 | 38.246 | 1.00 | 31.54 | | N |
| ANISOU | 747 | N | GLN | A | 137 | 2824 | 3878 | 5281 | 281 | −12 | −989 | N |
| ATOM | 748 | CA | GLN | A | 137 | −10.452 | 90.179 | 39.301 | 1.00 | 29.81 | | C |
| ANISOU | 748 | CA | GLN | A | 137 | 2689 | 3704 | 4934 | 270 | 153 | −975 | C |
| ATOM | 749 | C | GLN | A | 137 | −10.874 | 91.602 | 39.601 | 1.00 | 35.37 | | C |
| ANISOU | 749 | C | GLN | A | 137 | 3298 | 4366 | 5776 | 363 | 144 | −1069 | C |
| ATOM | 750 | O | GLN | A | 137 | −10.955 | 92.443 | 38.694 | 1.00 | 34.37 | | O |
| ANISOU | 750 | O | GLN | A | 137 | 3182 | 4154 | 5722 | 462 | −48 | −1055 | O |
| ATOM | 751 | CB | GLN | A | 137 | −8.971 | 90.153 | 38.919 | 1.00 | 32.05 | | C |
| ANISOU | 751 | CB | GLN | A | 137 | 3205 | 3993 | 4979 | 272 | 110 | −844 | C |
| ATOM | 752 | CG | GLN | A | 137 | −8.029 | 90.627 | 40.036 | 1.00 | 33.87 | | C |
| ANISOU | 752 | CG | GLN | A | 137 | 3525 | 4273 | 5069 | 245 | 262 | −825 | C |
| ATOM | 753 | CD | GLN | A | 137 | −7.940 | 89.633 | 41.193 | 1.00 | 35.95 | | C |
| ANISOU | 753 | CD | GLN | A | 137 | 3789 | 4620 | 5251 | 131 | 453 | −815 | C |
| ATOM | 754 | OE1 | GLN | A | 137 | −7.351 | 88.553 | 41.062 | 1.00 | 43.10 | | O |
| ANISOU | 754 | OE1 | GLN | A | 137 | 4787 | 5541 | 6049 | 72 | 458 | −722 | O |
| ATOM | 755 | NE2 | GLN | A | 137 | −8.544 | 89.985 | 42.321 | 1.00 | 31.39 | | N |
| ANISOU | 755 | NE2 | GLN | A | 137 | 3112 | 4089 | 4726 | 98 | 610 | −913 | N |
| ATOM | 756 | N | SER | A | 138 | −11.164 | 91.860 | 40.875 | 1.00 | 35.75 | | N |
| ANISOU | 756 | N | SER | A | 138 | 3259 | 4467 | 5860 | 326 | 351 | −1167 | N |
| ATOM | 757 | CA | SER | A | 138 | −11.308 | 93.222 | 41.372 | 1.00 | 34.34 | | C |
| ANISOU | 757 | CA | SER | A | 138 | 3023 | 4248 | 5777 | 406 | 385 | −1271 | C |
| ATOM | 758 | C | SER | A | 138 | −10.027 | 93.622 | 42.080 | 1.00 | 35.30 | | C |
| ANISOU | 758 | C | SER | A | 138 | 3333 | 4412 | 5669 | 376 | 477 | −1219 | C |
| ATOM | 759 | O | SER | A | 138 | −9.537 | 92.913 | 42.955 | 1.00 | 41.09 | | O |
| ANISOU | 759 | O | SER | A | 138 | 4142 | 5241 | 6228 | 271 | 636 | −1188 | O |
| ATOM | 760 | CB | SER | A | 138 | −12.488 | 93.349 | 42.325 | 1.00 | 37.02 | | C |
| ANISOU | 760 | CB | SER | A | 138 | 3134 | 4620 | 6310 | 388 | 567 | −1448 | C |
| ATOM | 761 | OG | SER | A | 138 | −13.700 | 93.221 | 41.623 | 1.00 | 45.03 | | O |
| ANISOU | 761 | OG | SER | A | 138 | 3940 | 5576 | 7592 | 438 | 452 | −1513 | O |
| ATOM | 762 | N | TYR | A | 139 | −9.482 | 94.762 | 41.700 | 1.00 | 24.94 | | N |
| ANISOU | 762 | N | TYR | A | 139 | 2097 | 3018 | 4362 | 462 | 363 | −1203 | N |
| ATOM | 763 | CA | TYR | A | 139 | −8.286 | 95.257 | 42.348 | 1.00 | 24.00 | | C |
| ANISOU | 763 | CA | TYR | A | 139 | 2137 | 2925 | 4057 | 433 | 431 | −1169 | C |
| ATOM | 764 | C | TYR | A | 139 | −8.630 | 96.402 | 43.286 | 1.00 | 27.62 | | C |
| ANISOU | 764 | C | TYR | A | 139 | 2516 | 3358 | 4620 | 472 | 536 | −1336 | C |
| ATOM | 765 | O | TYR | A | 139 | −9.670 | 97.047 | 43.128 | 1.00 | 26.99 | | O |
| ANISOU | 765 | O | TYR | A | 139 | 2269 | 3200 | 4786 | 557 | 504 | −1458 | O |
| ATOM | 766 | CB | TYR | A | 139 | −7.270 | 95.711 | 41.316 | 1.00 | 22.82 | | C |
| ANISOU | 766 | CB | TYR | A | 139 | 2145 | 2702 | 3824 | 478 | 252 | −1030 | C |
| ATOM | 767 | CG | TYR | A | 139 | −6.678 | 94.619 | 40.446 | 1.00 | 21.48 | | C |
| ANISOU | 767 | CG | TYR | A | 139 | 2084 | 2566 | 3511 | 435 | 176 | −880 | C |
| ATOM | 768 | CD1 | TYR | A | 139 | −5.660 | 93.808 | 40.916 | 1.00 | 20.24 | | C |
| ANISOU | 768 | CD1 | TYR | A | 139 | 2045 | 2493 | 3152 | 349 | 268 | −799 | C |
| ATOM | 769 | CD2 | TYR | A | 139 | −7.082 | 94.456 | 39.134 | 1.00 | 28.96 | | C |
| ANISOU | 769 | CD2 | TYR | A | 139 | 3026 | 3453 | 4524 | 484 | 0 | −823 | C |
| ATOM | 770 | CE1 | TYR | A | 139 | −5.081 | 92.857 | 40.115 | 1.00 | 19.23 | | C |
| ANISOU | 770 | CE1 | TYR | A | 139 | 2008 | 2380 | 2917 | 321 | 207 | −683 | C |
| ATOM | 771 | CE2 | TYR | A | 139 | −6.504 | 93.503 | 38.315 | 1.00 | 20.66 | | C |
| ANISOU | 771 | CE2 | TYR | A | 139 | 2086 | 2431 | 3333 | 445 | −59 | −711 | C |
| ATOM | 772 | CZ | TYR | A | 139 | −5.512 | 92.699 | 38.812 | 1.00 | 26.64 | | C |
| ANISOU | 772 | CZ | TYR | A | 139 | 2942 | 3265 | 3916 | 367 | 55 | −649 | C |
| ATOM | 773 | OH | TYR | A | 139 | −4.945 | 91.739 | 38.000 | 1.00 | 21.35 | | O |
| ANISOU | 773 | OH | TYR | A | 139 | 2368 | 2611 | 3133 | 338 | 7 | −559 | O |
| ATOM | 774 | N | CYS | A | 140 | −7.774 | 96.620 | 44.281 | 1.00 | 26.87 | | N |
| ANISOU | 774 | N | CYS | A | 140 | 2535 | 3327 | 4347 | 409 | 657 | −1352 | N |
| ATOM | 775 | CA | CYS | A | 140 | −7.981 | 97.669 | 45.273 | 1.00 | 30.13 | | C |
| ANISOU | 775 | CA | CYS | A | 140 | 2902 | 3726 | 4821 | 430 | 774 | −1531 | C |
| ATOM | 776 | C | CYS | A | 140 | −8.129 | 99.066 | 44.655 | 1.00 | 32.42 | | C |
| ANISOU | 776 | C | CYS | A | 140 | 3150 | 3846 | 5323 | 561 | 626 | −1587 | C |
| ATOM | 777 | O | CYS | A | 140 | −8.900 | 99.893 | 45.147 | 1.00 | 32.91 | | O |
| ANISOU | 777 | O | CYS | A | 140 | 3094 | 3855 | 5553 | 608 | 680 | −1746 | O |
| ATOM | 778 | CB | CYS | A | 140 | −6.826 | 97.670 | 46.280 | 1.00 | 26.52 | | C |
| ANISOU | 778 | CB | CYS | A | 140 | 2614 | 3358 | 4103 | 336 | 872 | −1511 | C |
| ATOM | 779 | SG | CYS | A | 140 | −6.957 | 96.383 | 47.544 | 1.00 | 59.64 | | S |
| ANISOU | 779 | SG | CYS | A | 140 | 6836 | 7746 | 8080 | 180 | 1101 | −1517 | S |
| ATOM | 780 | N | GLU | A | 141 | −7.390 | 99.320 | 43.579 | 1.00 | 36.65 | | N |
| ANISOU | 780 | N | GLU | A | 141 | 3799 | 4295 | 5831 | 600 | 429 | −1426 | N |
| ATOM | 781 | CA | GLU | A | 141 | −7.426 | 100.619 | 42.906 | 1.00 | 36.27 | | C |
| ANISOU | 781 | CA | GLU | A | 141 | 3744 | 4069 | 5968 | 711 | 266 | −1433 | C |
| ATOM | 782 | C | GLU | A | 141 | −8.805 | 100.904 | 42.309 | 1.00 | 39.43 | | C |
| ANISOU | 782 | C | GLU | A | 141 | 3949 | 4368 | 6664 | 823 | 168 | −1509 | C |
| ATOM | 783 | O | GLU | A | 141 | −9.139 | 102.073 | 42.072 | 1.00 | 29.97 | | O |
| ANISOU | 783 | O | GLU | A | 141 | 2702 | 3016 | 5669 | 918 | 62 | −1561 | O |
| ATOM | 784 | CB | GLU | A | 141 | −6.353 | 100.694 | 41.808 | 1.00 | 25.43 | | C |
| ANISOU | 784 | CB | GLU | A | 141 | 2546 | 2642 | 4475 | 706 | 92 | −1219 | C |
| ATOM | 785 | CG | GLU | A | 141 | −6.619 | 99.762 | 40.641 | 1.00 | 24.71 | | C |
| ANISOU | 785 | CG | GLU | A | 141 | 2463 | 2574 | 4352 | 708 | −30 | −1079 | C |
| ATOM | 786 | CD | GLU | A | 141 | −5.485 | 99.710 | 39.645 | 1.00 | 30.29 | | C |
| ANISOU | 786 | CD | GLU | A | 141 | 3354 | 3260 | 4895 | 681 | −150 | −883 | C |
| ATOM | 787 | OE1 | GLU | A | 141 | −4.333 | 100.016 | 40.035 | 1.00 | 30.52 | | O |
| ANISOU | 787 | OE1 | GLU | A | 141 | 3500 | 3304 | 4792 | 627 | −96 | −841 | O |
| ATOM | 788 | OE2 | GLU | A | 141 | −5.746 | 99.350 | 38.474 | 1.00 | 28.31 | | O |
| ANISOU | 788 | OE2 | GLU | A | 141 | 3127 | 2983 | 4647 | 706 | −294 | −778 | O |
| ATOM | 789 | N | GLY | A | 142 | −9.600 | 99.851 | 42.068 | 1.00 | 34.32 | | N |
| ANISOU | 789 | N | GLY | A | 142 | 3194 | 3799 | 6046 | 800 | 186 | −1503 | N |
| ATOM | 790 | CA | GLY | A | 142 | −10.968 | 100.011 | 41.562 | 1.00 | 30.38 | | C |
| ANISOU | 790 | CA | GLY | A | 142 | 2494 | 3225 | 5824 | 883 | 86 | −1569 | C |
| ATOM | 791 | C | GLY | A | 142 | −11.248 | 99.351 | 40.214 | 1.00 | 36.28 | | C |
| ANISOU | 791 | C | GLY | A | 142 | 3235 | 3942 | 6607 | 916 | −128 | −1434 | C |
| ATOM | 792 | O | GLY | A | 142 | −12.376 | 99.325 | 39.739 | 1.00 | 46.20 | | O |
| ANISOU | 792 | O | GLY | A | 142 | 4332 | 5151 | 8070 | 965 | −235 | −1471 | O |
| ATOM | 793 | N | SER | A | 143 | −10.210 | 98.804 | 39.599 | 1.00 | 28.05 | | N |
| ANISOU | 793 | N | SER | A | 143 | 2401 | 2947 | 5309 | 852 | −194 | −1252 | N |
| ATOM | 794 | CA | SER | A | 143 | −10.331 | 98.133 | 38.317 | 1.00 | 38.81 | | C |
| ANISOU | 794 | CA | SER | A | 143 | 3814 | 4304 | 6630 | 853 | −386 | −1115 | C |
| ATOM | 795 | C | SER | A | 143 | −11.078 | 96.796 | 38.426 | 1.00 | 39.77 | | C |
| ANISOU | 795 | C | SER | A | 143 | 3815 | 4531 | 6765 | 787 | −313 | −1159 | C |
| ATOM | 796 | O | SER | A | 143 | −10.786 | 95.984 | 39.311 | 1.00 | 29.01 | | O |
| ANISOU | 796 | O | SER | A | 143 | 2467 | 3287 | 5269 | 687 | −105 | −1186 | O |
| ATOM | 797 | CB | SER | A | 143 | −8.936 | 97.878 | 37.724 | 1.00 | 37.64 | | C |
| ANISOU | 797 | CB | SER | A | 143 | 3919 | 4188 | 6196 | 793 | −428 | −934 | C |
| ATOM | 798 | OG | SER | A | 143 | −8.102 | 99.012 | 37.795 | 1.00 | 47.66 | | O |
| ANISOU | 798 | OG | SER | A | 143 | 5302 | 5374 | 7432 | 820 | −451 | −892 | O |
| ATOM | 799 | N | GLN | A | 144 | −12.028 | 96.572 | 37.519 | 1.00 | 45.89 | | N |
| ANISOU | 799 | N | GLN | A | 144 | 4478 | 5254 | 7703 | 837 | −498 | −1158 | N |
| ATOM | 800 | CA | GLN | A | 144 | −12.673 | 95.266 | 37.356 | 1.00 | 40.47 | | C |
| ANISOU | 800 | CA | GLN | A | 144 | 3698 | 4648 | 7032 | 766 | −479 | −1177 | C |
| ATOM | 801 | C | GLN | A | 144 | −12.273 | 94.679 | 36.015 | 1.00 | 36.43 | | C |
| ANISOU | 801 | C | GLN | A | 144 | 3346 | 4130 | 6365 | 750 | −686 | −1030 | C |
| ATOM | 802 | O | GLN | A | 144 | −12.666 | 95.195 | 34.967 | 1.00 | 40.04 | | O |
| ANISOU | 802 | O | GLN | A | 144 | 3807 | 4496 | 6910 | 830 | −938 | −984 | O |
| ATOM | 803 | CB | GLN | A | 144 | −14.199 | 95.383 | 37.418 | 1.00 | 49.83 | | C |
| ANISOU | 803 | CB | GLN | A | 144 | 4590 | 5785 | 8556 | 824 | −525 | −1324 | C |
| ATOM | 804 | CG | GLN | A | 144 | −14.721 | 96.333 | 38.478 | 1.00 | 70.20 | | C |
| ANISOU | 804 | CG | GLN | A | 144 | 7023 | 8334 | 11318 | 866 | −369 | −1476 | C |
| ATOM | 805 | CD | GLN | A | 144 | −14.911 | 95.676 | 39.824 | 1.00 | 80.11 | | C |
| ANISOU | 805 | CD | GLN | A | 144 | 8206 | 9717 | 12518 | 747 | −49 | −1580 | C |
| ATOM | 806 | OE1 | GLN | A | 144 | −15.144 | 94.473 | 39.913 | 1.00 | 79.58 | | O |
| ANISOU | 806 | OE1 | GLN | A | 144 | 8084 | 9736 | 12418 | 656 | 33 | −1577 | O |
| ATOM | 807 | NE2 | GLN | A | 144 | −14.801 | 96.465 | 40.887 | 1.00 | 86.82 | | N |
| ANISOU | 807 | NE2 | GLN | A | 144 | 9069 | 10575 | 13342 | 735 | 127 | −1666 | N |
| ATOM | 808 | N | ILE | A | 145 | −11.544 | 93.574 | 36.049 | 1.00 | 26.70 | | N |
| ANISOU | 808 | N | ILE | A | 145 | 2244 | 2991 | 4908 | 647 | −586 | −964 | N |
| ATOM | 809 | CA | ILE | A | 145 | −11.106 | 92.900 | 34.836 | 1.00 | 38.17 | | C |
| ANISOU | 809 | CA | ILE | A | 145 | 3856 | 4451 | 6195 | 621 | −744 | −853 | C |
| ATOM | 810 | C | ILE | A | 145 | −11.777 | 91.526 | 34.743 | 1.00 | 32.32 | | C |
| ANISOU | 810 | C | ILE | A | 145 | 3019 | 3761 | 5499 | 544 | −726 | −904 | C |
| ATOM | 811 | O | ILE | A | 145 | −11.759 | 90.747 | 35.683 | 1.00 | 31.54 | | O |
| ANISOU | 811 | O | ILE | A | 145 | 2865 | 3728 | 5390 | 462 | −520 | −946 | O |
| ATOM | 812 | CB | ILE | A | 145 | −9.548 | 92.742 | 34.799 | 1.00 | 30.53 | | C |
| ANISOU | 812 | CB | ILE | A | 145 | 3132 | 3531 | 4938 | 571 | −654 | −735 | C |
| ATOM | 813 | CG1 | ILE | A | 145 | −8.870 | 94.076 | 35.131 | 1.00 | 28.42 | | C |
| ANISOU | 813 | CG1 | ILE | A | 145 | 2937 | 3214 | 4648 | 625 | −633 | −700 | C |
| ATOM | 814 | CG2 | ILE | A | 145 | −9.082 | 92.221 | 33.439 | 1.00 | 29.05 | | C |
| ANISOU | 814 | CG2 | ILE | A | 145 | 3115 | 3344 | 4577 | 555 | −811 | −637 | C |
| ATOM | 815 | CD1 | ILE | A | 145 | −9.228 | 95.203 | 34.183 | 1.00 | 25.37 | | C |
| ANISOU | 815 | CD1 | ILE | A | 145 | 2571 | 2712 | 4359 | 721 | −865 | −654 | C |
| ATOM | 816 | N | SER | A | 146 | −12.378 | 91.240 | 33.604 | 1.00 | 33.07 | | N |
| ANISOU | 816 | N | SER | A | 146 | 3101 | 3819 | 5645 | 564 | −953 | −897 | N |
| ATOM | 817 | CA | SER | A | 146 | −13.031 | 89.962 | 33.409 | 1.00 | 32.62 | | C |
| ANISOU | 817 | CA | SER | A | 146 | 2954 | 3792 | 5648 | 487 | −965 | −953 | C |
| ATOM | 818 | C | SER | A | 146 | −12.641 | 89.321 | 32.077 | 1.00 | 34.86 | | C |
| ANISOU | 818 | C | SER | A | 146 | 3420 | 4075 | 5751 | 464 | −1150 | −886 | C |
| ATOM | 819 | O | SER | A | 146 | −12.147 | 89.996 | 31.176 | 1.00 | 28.09 | | O |
| ANISOU | 819 | O | SER | A | 146 | 2727 | 3189 | 4756 | 518 | −1308 | −801 | O |
| ATOM | 820 | CB | SER | A | 146 | −14.540 | 90.135 | 33.501 | 1.00 | 30.29 | | C |
| ANISOU | 820 | CB | SER | A | 146 | 2376 | 3453 | 5679 | 522 | −1056 | −1073 | C |
| ATOM | 821 | OG | SER | A | 146 | −15.003 | 90.988 | 32.477 | 1.00 | 46.33 | | O |
| ANISOU | 821 | OG | SER | A | 146 | 4400 | 5403 | 7798 | 625 | −1347 | −1050 | O |
| ATOM | 822 | N | GLY | A | 147 | −12.831 | 88.006 | 31.974 | 1.00 | 37.79 | | N |
| ANISOU | 822 | N | GLY | A | 147 | 3773 | 4475 | 6112 | 374 | −1117 | −927 | N |
| ATOM | 823 | CA | GLY | A | 147 | −12.610 | 87.296 | 30.727 | 1.00 | 28.39 | | C |
| ANISOU | 823 | CA | GLY | A | 147 | 2736 | 3282 | 4770 | 346 | −1287 | −906 | C |
| ATOM | 824 | C | GLY | A | 147 | −12.752 | 85.805 | 30.917 | 1.00 | 28.33 | | C |
| ANISOU | 824 | C | GLY | A | 147 | 2690 | 3289 | 4783 | 238 | −1193 | −966 | C |
| ATOM | 825 | O | GLY | A | 147 | −13.593 | 85.352 | 31.683 | 1.00 | 36.84 | | O |
| ANISOU | 825 | O | GLY | A | 147 | 3561 | 4362 | 6075 | 189 | −1102 | −1040 | O |
| ATOM | 826 | N | PHE | A | 148 | −11.907 | 85.036 | 30.240 | 1.00 | 30.04 | | N |
| ANISOU | 826 | N | PHE | A | 148 | 3107 | 3519 | 4788 | 198 | −1200 | −937 | N |
| ATOM | 827 | CA | PHE | A | 148 | −11.934 | 83.589 | 30.383 | 1.00 | 29.33 | | C |
| ANISOU | 827 | CA | PHE | A | 148 | 3003 | 3419 | 4722 | 100 | −1116 | −992 | C |
| ATOM | 828 | C | PHE | A | 148 | −10.536 | 83.024 | 30.608 | 1.00 | 34.22 | | C |
| ANISOU | 828 | C | PHE | A | 148 | 3808 | 4059 | 5136 | 73 | −939 | −928 | C |
| ATOM | 829 | O | PHE | A | 148 | −9.530 | 83.655 | 30.259 | 1.00 | 25.09 | | O |
| ANISOU | 829 | O | PHE | A | 148 | 2819 | 2931 | 3783 | 125 | −927 | −855 | O |
| ATOM | 830 | CB | PHE | A | 148 | −12.570 | 82.935 | 29.153 | 1.00 | 34.43 | | C |
| ANISOU | 830 | CB | PHE | A | 148 | 3669 | 4033 | 5381 | 72 | −1352 | −1074 | C |
| ATOM | 831 | CG | PHE | A | 148 | −11.847 | 83.224 | 27.859 | 1.00 | 39.26 | | C |
| ANISOU | 831 | CG | PHE | A | 148 | 4528 | 4664 | 5724 | 111 | −1503 | −1039 | C |
| ATOM | 832 | CD1 | PHE | A | 148 | −10.769 | 82.433 | 27.450 | 1.00 | 32.88 | | C |
| ANISOU | 832 | CD1 | PHE | A | 148 | 3919 | 3869 | 4705 | 75 | −1411 | −1037 | C |
| ATOM | 833 | CD2 | PHE | A | 148 | −12.258 | 84.277 | 27.039 | 1.00 | 45.73 | | C |
| ANISOU | 833 | CD2 | PHE | A | 148 | 5382 | 5485 | 6509 | 182 | −1737 | −1008 | C |
| ATOM | 834 | CE1 | PHE | A | 148 | −10.097 | 82.697 | 26.255 | 1.00 | 32.14 | | C |
| ANISOU | 834 | CE1 | PHE | A | 148 | 4056 | 3806 | 4349 | 99 | −1519 | −1016 | C |
| ATOM | 835 | CE2 | PHE | A | 148 | −11.591 | 84.560 | 25.838 | 1.00 | 44.30 | | C |
| ANISOU | 835 | CE2 | PHE | A | 148 | 5451 | 5330 | 6050 | 201 | −1866 | −960 | C |
| ATOM | 836 | CZ | PHE | A | 148 | −10.511 | 83.770 | 25.447 | 1.00 | 43.13 | | C |
| ANISOU | 836 | CZ | PHE | A | 148 | 5501 | 5213 | 5674 | 155 | −1743 | −970 | C |
| ATOM | 837 | N | TYR | A | 149 | −10.495 | 81.815 | 31.162 | 1.00 | 25.89 | | N |
| ANISOU | 837 | N | TYR | A | 149 | 2714 | 2977 | 4144 | −10 | −810 | −954 | N |
| ATOM | 838 | CA | TYR | A | 149 | −9.250 | 81.138 | 31.464 | 1.00 | 28.29 | | C |
| ANISOU | 838 | CA | TYR | A | 149 | 3161 | 3280 | 4308 | −33 | −652 | −899 | C |
| ATOM | 839 | C | TYR | A | 149 | −8.779 | 80.257 | 30.304 | 1.00 | 31.61 | | C |
| ANISOU | 839 | C | TYR | A | 149 | 3733 | 3667 | 4610 | −48 | −740 | −954 | C |
| ATOM | 840 | O | TYR | A | 149 | −9.577 | 79.721 | 29.542 | 1.00 | 41.98 | | O |
| ANISOU | 840 | O | TYR | A | 149 | 5015 | 4944 | 5992 | −83 | −891 | −1050 | O |
| ATOM | 841 | CB | TYR | A | 149 | −9.404 | 80.274 | 32.717 | 1.00 | 30.65 | | C |
| ANISOU | 841 | CB | TYR | A | 149 | 3355 | 3552 | 4738 | −117 | −472 | −880 | C |
| ATOM | 842 | CG | TYR | A | 149 | −9.172 | 80.987 | 34.039 | 1.00 | 32.26 | | C |
| ANISOU | 842 | CG | TYR | A | 149 | 3504 | 3808 | 4945 | −110 | −302 | −801 | C |
| ATOM | 843 | CD1 | TYR | A | 149 | −7.879 | 81.288 | 34.472 | 1.00 | 21.99 | | C |
| ANISOU | 843 | CD1 | TYR | A | 149 | 2335 | 2540 | 3482 | −76 | −195 | −710 | C |
| ATOM | 844 | CD2 | TYR | A | 149 | −10.241 | 81.326 | 34.863 | 1.00 | 24.25 | | C |
| ANISOU | 844 | CD2 | TYR | A | 149 | 2300 | 2812 | 4101 | −143 | −244 | −833 | C |
| ATOM | 845 | CE1 | TYR | A | 149 | −7.657 | 81.922 | 35.690 | 1.00 | 21.32 | | C |
| ANISOU | 845 | CE1 | TYR | A | 149 | 2212 | 2504 | 3383 | −78 | −55 | −650 | C |
| ATOM | 846 | CE2 | TYR | A | 149 | −10.038 | 81.945 | 36.066 | 1.00 | 23.63 | | C |
| ANISOU | 846 | CE2 | TYR | A | 149 | 2188 | 2788 | 4004 | −144 | −81 | −783 | C |
| ATOM | 847 | CZ | TYR | A | 149 | −8.744 | 82.248 | 36.478 | 1.00 | 33.78 | | C |
| ANISOU | 847 | CZ | TYR | A | 149 | 3625 | 4105 | 5107 | −113 | 4 | −691 | C |
| ATOM | 848 | OH | TYR | A | 149 | −8.543 | 82.877 | 37.679 | 1.00 | 32.76 | | O |
| ANISOU | 848 | OH | TYR | A | 149 | 3472 | 4033 | 4944 | −121 | 151 | −654 | O |
| ATOM | 849 | N | PHE | A | 150 | −7.466 | 80.141 | 30.164 | 1.00 | 25.26 | | N |
| ANISOU | 849 | N | PHE | A | 150 | 3089 | 2875 | 3632 | −22 | −643 | −906 | N |
| ATOM | 850 | CA | PHE | A | 150 | −6.873 | 79.183 | 29.260 | 1.00 | 27.70 | | C |
| ANISOU | 850 | CA | PHE | A | 150 | 3534 | 3148 | 3842 | −38 | −664 | −974 | C |
| ATOM | 851 | C | PHE | A | 150 | −5.525 | 78.805 | 29.850 | 1.00 | 28.11 | | C |
| ANISOU | 851 | C | PHE | A | 150 | 3660 | 3190 | 3830 | −25 | −476 | −907 | C |
| ATOM | 852 | O | PHE | A | 150 | −5.000 | 79.530 | 30.694 | 1.00 | 30.28 | | O |
| ANISOU | 852 | O | PHE | A | 150 | 3916 | 3509 | 4082 | 4 | −373 | −804 | O |
| ATOM | 853 | CB | PHE | A | 150 | −6.713 | 79.771 | 27.862 | 1.00 | 32.53 | | C |
| ANISOU | 853 | CB | PHE | A | 150 | 4297 | 3807 | 4257 | 2 | −813 | −1011 | C |
| ATOM | 854 | CG | PHE | A | 150 | −5.522 | 80.685 | 27.732 | 1.00 | 36.88 | | C |
| ANISOU | 854 | CG | PHE | A | 150 | 4978 | 4420 | 4613 | 60 | −727 | −917 | C |
| ATOM | 855 | CD1 | PHE | A | 150 | −5.529 | 81.932 | 28.320 | 1.00 | 31.37 | | C |
| ANISOU | 855 | CD1 | PHE | A | 150 | 4232 | 3763 | 3924 | 103 | −711 | −814 | C |
| ATOM | 856 | CD2 | PHE | A | 150 | −4.398 | 80.295 | 27.016 | 1.00 | 33.10 | | C |
| ANISOU | 856 | CD2 | PHE | A | 150 | 4662 | 3954 | 3960 | 68 | −653 | −944 | C |
| ATOM | 857 | CE1 | PHE | A | 150 | −4.437 | 82.774 | 28.213 | 1.00 | 32.57 | | C |
| ANISOU | 857 | CE1 | PHE | A | 150 | 4496 | 3962 | 3918 | 143 | −634 | −727 | C |
| ATOM | 858 | CE2 | PHE | A | 150 | −3.311 | 81.143 | 26.902 | 1.00 | 28.39 | | C |
| ANISOU | 858 | CE2 | PHE | A | 150 | 4166 | 3416 | 3205 | 108 | −562 | −857 | C |
| ATOM | 859 | CZ | PHE | A | 150 | −3.332 | 82.379 | 27.502 | 1.00 | 29.18 | | C |
| ANISOU | 859 | CZ | PHE | A | 150 | 4218 | 3551 | 3320 | 141 | −558 | −743 | C |
| ATOM | 860 | N | SER | A | 151 | −4.975 | 77.670 | 29.425 | 1.00 | 25.10 | | N |
| ANISOU | 860 | N | SER | A | 151 | 3355 | 2745 | 3438 | −45 | −441 | −974 | N |
| ATOM | 861 | CA | SER | A | 151 | −3.607 | 77.310 | 29.773 | 1.00 | 27.99 | | C |
| ANISOU | 861 | CA | SER | A | 151 | 3790 | 3093 | 3751 | −15 | −289 | −924 | C |
| ATOM | 862 | C | SER | A | 151 | −2.737 | 77.226 | 28.520 | 1.00 | 30.62 | | C |
| ANISOU | 862 | C | SER | A | 151 | 4281 | 3446 | 3908 | 23 | −292 | −1004 | C |
| ATOM | 863 | O | SER | A | 151 | −3.221 | 76.953 | 27.413 | 1.00 | 25.78 | | O |
| ANISOU | 863 | O | SER | A | 151 | 3738 | 2829 | 3227 | 5 | −407 | −1123 | O |
| ATOM | 864 | CB | SER | A | 151 | −3.544 | 75.980 | 30.524 | 1.00 | 29.85 | | C |
| ANISOU | 864 | CB | SER | A | 151 | 3968 | 3214 | 4160 | −63 | −212 | −924 | C |
| ATOM | 865 | OG | SER | A | 151 | −4.021 | 74.932 | 29.702 | 1.00 | 30.43 | | O |
| ANISOU | 865 | OG | SER | A | 151 | 4064 | 3200 | 4296 | −102 | −293 | −1063 | O |
| ATOM | 866 | N | ASP | A | 152 | −1.446 | 77.446 | 28.730 | 1.00 | 22.83 | | N |
| ANISOU | 866 | N | ASP | A | 152 | 3346 | 2483 | 2847 | 69 | −161 | −944 | N |
| ATOM | 867 | CA | ASP | A | 152 | −0.451 | 77.419 | 27.687 | 1.00 | 23.44 | | C |
| ANISOU | 867 | CA | ASP | A | 152 | 3556 | 2589 | 2762 | 102 | −108 | −1012 | C |
| ATOM | 868 | C | ASP | A | 152 | 0.916 | 77.313 | 28.358 | 1.00 | 26.87 | | C |
| ANISOU | 868 | C | ASP | A | 152 | 3969 | 3009 | 3231 | 145 | 55 | −941 | C |
| ATOM | 869 | O | ASP | A | 152 | 1.042 | 77.426 | 29.584 | 1.00 | 21.49 | | O |
| ANISOU | 869 | O | ASP | A | 152 | 3193 | 2311 | 2663 | 147 | 97 | −827 | O |
| ATOM | 870 | CB | ASP | A | 152 | −0.550 | 78.676 | 26.816 | 1.00 | 23.61 | | C |
| ANISOU | 870 | CB | ASP | A | 152 | 3677 | 2721 | 2574 | 113 | −180 | −989 | C |
| ATOM | 871 | CG | ASP | A | 152 | −0.080 | 78.453 | 25.377 | 1.00 | 37.25 | | C |
| ANISOU | 871 | CG | ASP | A | 152 | 5571 | 4483 | 4100 | 110 | −177 | −1108 | C |
| ATOM | 872 | OD1 | ASP | A | 152 | 0.823 | 77.609 | 25.122 | 1.00 | 30.94 | | O |
| ANISOU | 872 | OD1 | ASP | A | 152 | 4808 | 3645 | 3304 | 123 | −50 | −1195 | O |
| ATOM | 873 | OD2 | ASP | A | 152 | −0.627 | 79.146 | 24.495 | 1.00 | 26.01 | | O |
| ANISOU | 873 | OD2 | ASP | A | 152 | 4245 | 3125 | 2514 | 93 | −305 | −1114 | O |
| ATOM | 874 | N | VAL | A | 153 | 1.945 | 77.087 | 27.559 | 1.00 | 23.31 | | N |
| ANISOU | 874 | N | VAL | A | 153 | 3604 | 2568 | 2685 | 175 | 146 | −1016 | N |
| ATOM | 875 | CA | VAL | A | 153 | 3.288 | 77.033 | 28.100 | 1.00 | 22.77 | | C |
| ANISOU | 875 | CA | VAL | A | 153 | 3496 | 2488 | 2669 | 221 | 290 | −959 | C |
| ATOM | 876 | C | VAL | A | 153 | 3.814 | 78.416 | 28.462 | 1.00 | 34.11 | | C |
| ANISOU | 876 | C | VAL | A | 153 | 4925 | 4026 | 4008 | 234 | 327 | −825 | C |
| ATOM | 877 | O | VAL | A | 153 | 3.727 | 79.379 | 27.674 | 1.00 | 28.96 | | O |
| ANISOU | 877 | O | VAL | A | 153 | 4362 | 3462 | 3177 | 223 | 302 | −819 | O |
| ATOM | 878 | CB | VAL | A | 153 | 4.255 | 76.352 | 27.118 | 1.00 | 29.50 | | C |
| ANISOU | 878 | CB | VAL | A | 153 | 4417 | 3316 | 3475 | 252 | 400 | −1102 | C |
| ATOM | 879 | CG1 | VAL | A | 153 | 5.665 | 76.458 | 27.615 | 1.00 | 24.81 | | C |
| ANISOU | 879 | CG1 | VAL | A | 153 | 3757 | 2719 | 2948 | 304 | 542 | −1043 | C |
| ATOM | 880 | CG2 | VAL | A | 153 | 3.860 | 74.889 | 26.927 | 1.00 | 25.48 | | C |
| ANISOU | 880 | CG2 | VAL | A | 153 | 3900 | 2672 | 3110 | 245 | 371 | −1242 | C |
| ATOM | 881 | N | VAL | A | 154 | 4.371 | 78.504 | 29.663 | 1.00 | 32.57 | | N |
| ANISOU | 881 | N | VAL | A | 154 | 4634 | 3810 | 3932 | 253 | 375 | −714 | N |
| ATOM | 882 | CA | VAL | A | 154 | 5.091 | 79.700 | 30.075 | 1.00 | 30.92 | | C |
| ANISOU | 882 | CA | VAL | A | 154 | 4409 | 3680 | 3660 | 265 | 422 | −603 | C |
| ATOM | 883 | C | VAL | A | 154 | 6.585 | 79.375 | 30.074 | 1.00 | 28.68 | | C |
| ANISOU | 883 | C | VAL | A | 154 | 4092 | 3379 | 3428 | 306 | 551 | −612 | C |
| ATOM | 884 | O | VAL | A | 154 | 6.986 | 78.346 | 30.617 | 1.00 | 31.65 | | O |
| ANISOU | 884 | O | VAL | A | 154 | 4398 | 3663 | 3963 | 333 | 574 | −623 | O |
| ATOM | 885 | CB | VAL | A | 154 | 4.670 | 80.158 | 31.473 | 1.00 | 28.35 | | C |
| ANISOU | 885 | CB | VAL | A | 154 | 3998 | 3357 | 3416 | 250 | 375 | −480 | C |
| ATOM | 886 | CG1 | VAL | A | 154 | 5.574 | 81.277 | 31.943 | 1.00 | 37.05 | | C |
| ANISOU | 886 | CG1 | VAL | A | 154 | 5081 | 4523 | 4475 | 262 | 424 | −384 | C |
| ATOM | 887 | CG2 | VAL | A | 154 | 3.227 | 80.615 | 31.464 | 1.00 | 30.80 | | C |
| ANISOU | 887 | CG2 | VAL | A | 154 | 4315 | 3691 | 3699 | 216 | 266 | −482 | C |
| ATOM | 888 | N | SER | A | 155 | 7.398 | 80.233 | 29.462 | 1.00 | 29.45 | | N |
| ANISOU | 888 | N | SER | A | 155 | 4229 | 3553 | 3408 | 308 | 632 | −603 | N |
| ATOM | 889 | CA | SER | A | 155 | 8.858 | 80.080 | 29.493 | 1.00 | 33.82 | | C |
| ANISOU | 889 | CA | SER | A | 155 | 4719 | 4100 | 4031 | 343 | 765 | −611 | C |
| ATOM | 890 | C | SER | A | 155 | 9.470 | 81.280 | 30.206 | 1.00 | 36.74 | | C |
| ANISOU | 890 | C | SER | A | 155 | 5035 | 4529 | 4395 | 331 | 776 | −479 | C |
| ATOM | 891 | O | SER | A | 155 | 9.392 | 82.408 | 29.732 | 1.00 | 30.51 | | O |
| ANISOU | 891 | O | SER | A | 155 | 4314 | 3814 | 3462 | 295 | 781 | −439 | O |
| ATOM | 892 | CB | SER | A | 155 | 9.454 | 79.973 | 28.089 | 1.00 | 37.95 | | C |
| ANISOU | 892 | CB | SER | A | 155 | 5323 | 4663 | 4432 | 341 | 892 | −736 | C |
| ATOM | 893 | OG | SER | A | 155 | 8.822 | 78.968 | 27.325 | 1.00 | 47.93 | | O |
| ANISOU | 893 | OG | SER | A | 155 | 6660 | 5881 | 5671 | 343 | 871 | −879 | O |
| ATOM | 894 | N | VAL | A | 156 | 10.143 | 81.017 | 31.316 | 1.00 | 37.93 | | N |
| ANISOU | 894 | N | VAL | A | 156 | 5070 | 4637 | 4706 | 358 | 773 | −412 | N |
| ATOM | 895 | CA | VAL | A | 156 | 10.829 | 82.067 | 32.034 | 1.00 | 32.38 | | C |
| ANISOU | 895 | CA | VAL | A | 156 | 4307 | 3982 | 4013 | 344 | 776 | −306 | C |
| ATOM | 896 | C | VAL | A | 156 | 12.320 | 81.940 | 31.775 | 1.00 | 28.01 | | C |
| ANISOU | 896 | C | VAL | A | 156 | 3665 | 3426 | 3551 | 372 | 898 | −334 | C |
| ATOM | 897 | O | VAL | A | 156 | 12.935 | 80.919 | 32.076 | 1.00 | 25.13 | | O |
| ANISOU | 897 | O | VAL | A | 156 | 3208 | 2986 | 3352 | 424 | 918 | −368 | O |
| ATOM | 898 | CB | VAL | A | 156 | 10.532 | 81.937 | 33.535 | 1.00 | 29.91 | | C |
| ANISOU | 898 | CB | VAL | A | 156 | 3930 | 3636 | 3799 | 343 | 669 | −208 | C |
| ATOM | 899 | CG1 | VAL | A | 156 | 10.843 | 83.216 | 34.272 | 1.00 | 22.32 | | C |
| ANISOU | 899 | CG1 | VAL | A | 156 | 2944 | 2735 | 2802 | 311 | 640 | −114 | C |
| ATOM | 900 | CG2 | VAL | A | 156 | 9.084 | 81.538 | 33.720 | 1.00 | 31.63 | | C |
| ANISOU | 900 | CG2 | VAL | A | 156 | 4205 | 3831 | 3984 | 323 | 584 | −218 | C |
| ATOM | 901 | N | VAL | A | 157 | 12.910 | 82.985 | 31.220 | 1.00 | 31.13 | | N |
| ANISOU | 901 | N | VAL | A | 157 | 4077 | 3893 | 3856 | 335 | 981 | −317 | N |
| ATOM | 902 | CA | VAL | A | 157 | 14.316 | 82.910 | 30.858 | 1.00 | 30.06 | | C |
| ANISOU | 902 | CA | VAL | A | 157 | 3842 | 3765 | 3813 | 350 | 1125 | −358 | C |
| ATOM | 903 | C | VAL | A | 157 | 15.055 | 84.041 | 31.532 | 1.00 | 38.15 | | C |
| ANISOU | 903 | C | VAL | A | 157 | 4788 | 4828 | 4879 | 312 | 1114 | −252 | C |
| ATOM | 904 | O | VAL | A | 157 | 14.686 | 85.201 | 31.368 | 1.00 | 32.60 | | O |
| ANISOU | 904 | O | VAL | A | 157 | 4167 | 4177 | 4042 | 252 | 1094 | −190 | O |
| ATOM | 905 | CB | VAL | A | 157 | 14.526 | 82.976 | 29.335 | 1.00 | 31.16 | | C |
| ANISOU | 905 | CB | VAL | A | 157 | 4074 | 3958 | 3806 | 322 | 1286 | −461 | C |
| ATOM | 906 | CG1 | VAL | A | 157 | 15.995 | 82.727 | 28.982 | 1.00 | 24.94 | | C |
| ANISOU | 906 | CG1 | VAL | A | 157 | 3154 | 3173 | 3148 | 341 | 1467 | −530 | C |
| ATOM | 907 | CG2 | VAL | A | 157 | 13.639 | 81.955 | 28.623 | 1.00 | 39.44 | | C |
| ANISOU | 907 | CG2 | VAL | A | 157 | 5229 | 4975 | 4783 | 346 | 1270 | −579 | C |
| ATOM | 908 | N | SER | A | 158 | 16.102 | 83.705 | 32.283 | 1.00 | 37.99 | | N |
| ANISOU | 908 | N | SER | A | 158 | 4605 | 4770 | 5059 | 348 | 1113 | −234 | N |
| ATOM | 909 | CA | SER | A | 158 | 16.926 | 84.720 | 32.928 | 1.00 | 26.58 | | C |
| ANISOU | 909 | CA | SER | A | 158 | 3067 | 3356 | 3677 | 308 | 1096 | −150 | C |
| ATOM | 910 | C | SER | A | 158 | 17.731 | 85.423 | 31.865 | 1.00 | 26.13 | | C |
| ANISOU | 910 | C | SER | A | 158 | 2998 | 3355 | 3575 | 255 | 1275 | −185 | C |
| ATOM | 911 | O | SER | A | 158 | 17.829 | 84.928 | 30.742 | 1.00 | 27.65 | | O |
| ANISOU | 911 | O | SER | A | 158 | 3233 | 3562 | 3709 | 263 | 1422 | −283 | O |
| ATOM | 912 | CB | SER | A | 158 | 17.865 | 84.102 | 33.963 | 1.00 | 30.04 | | C |
| ANISOU | 912 | CB | SER | A | 158 | 3326 | 3737 | 4351 | 362 | 1025 | −124 | C |
| ATOM | 913 | OG | SER | A | 158 | 18.955 | 83.456 | 33.331 | 1.00 | 35.25 | | O |
| ANISOU | 913 | OG | SER | A | 158 | 3853 | 4370 | 5169 | 408 | 1165 | −215 | O |
| ATOM | 914 | N | TYR | A | 159 | 18.352 | 86.548 | 32.208 | 1.00 | 28.97 | | N |
| ANISOU | 914 | N | TYR | A | 159 | 3300 | 3745 | 3962 | 192 | 1275 | −111 | N |
| ATOM | 915 | CA | TYR | A | 159 | 19.182 | 87.221 | 31.215 | 1.00 | 31.18 | | C |
| ANISOU | 915 | CA | TYR | A | 159 | 3561 | 4074 | 4211 | 123 | 1464 | −130 | C |
| ATOM | 916 | C | TYR | A | 159 | 20.576 | 86.585 | 31.147 | 1.00 | 32.33 | | C |
| ANISOU | 916 | C | TYR | A | 159 | 3492 | 4204 | 4587 | 159 | 1593 | −204 | C |
| ATOM | 917 | O | TYR | A | 159 | 21.445 | 87.033 | 30.397 | 1.00 | 30.51 | | O |
| ANISOU | 917 | O | TYR | A | 159 | 3201 | 4016 | 4375 | 99 | 1780 | −233 | O |
| ATOM | 918 | CB | TYR | A | 159 | 19.277 | 88.741 | 31.495 | 1.00 | 31.09 | | C |
| ANISOU | 918 | CB | TYR | A | 159 | 3578 | 4085 | 4150 | 27 | 1424 | −22 | C |
| ATOM | 919 | CG | TYR | A | 159 | 19.845 | 89.158 | 32.845 | 1.00 | 30.40 | | C |
| ANISOU | 919 | CG | TYR | A | 159 | 3346 | 3968 | 4237 | 23 | 1286 | 38 | C |
| ATOM | 920 | CD1 | TYR | A | 159 | 21.219 | 89.147 | 33.066 | 1.00 | 28.91 | | C |
| ANISOU | 920 | CD1 | TYR | A | 159 | 2950 | 3774 | 4260 | 11 | 1350 | 22 | C |
| ATOM | 921 | CD2 | TYR | A | 159 | 19.024 | 89.671 | 33.857 | 1.00 | 28.74 | | C |
| ANISOU | 921 | CD2 | TYR | A | 159 | 3206 | 3739 | 3974 | 19 | 1097 | 102 | C |
| ATOM | 922 | CE1 | TYR | A | 159 | 21.760 | 89.541 | 34.270 | 1.00 | 24.50 | | C |
| ANISOU | 922 | CE1 | TYR | A | 159 | 2265 | 3192 | 3852 | −1 | 1203 | 73 | C |
| ATOM | 923 | CE2 | TYR | A | 159 | 19.569 | 90.098 | 35.084 | 1.00 | 26.87 | | C |
| ANISOU | 923 | CE2 | TYR | A | 159 | 2856 | 3485 | 3867 | 2 | 969 | 145 | C |
| ATOM | 924 | CZ | TYR | A | 159 | 20.950 | 90.026 | 35.271 | 1.00 | 30.05 | | C |
| ANISOU | 924 | CZ | TYR | A | 159 | 3062 | 3884 | 4474 | −9 | 1011 | 133 | C |
| ATOM | 925 | OH | TYR | A | 159 | 21.559 | 90.415 | 36.450 | 1.00 | 28.98 | | O |
| ANISOU | 925 | OH | TYR | A | 159 | 2810 | 3733 | 4469 | −30 | 864 | 170 | O |
| ATOM | 926 | N | ASN | A | 160 | 20.775 | 85.518 | 31.914 | 1.00 | 33.48 | | N |
| ANISOU | 926 | N | ASN | A | 160 | 3518 | 4284 | 4918 | 255 | 1496 | −234 | N |
| ATOM | 927 | CA | ASN | A | 160 | 21.939 | 84.652 | 31.729 | 1.00 | 32.68 | | C |
| ANISOU | 927 | CA | ASN | A | 160 | 3212 | 4145 | 5059 | 321 | 1610 | −330 | C |
| ATOM | 928 | C | ASN | A | 160 | 21.514 | 83.344 | 31.057 | 1.00 | 36.05 | | C |
| ANISOU | 928 | C | ASN | A | 160 | 3695 | 4527 | 5477 | 404 | 1680 | −457 | C |
| ATOM | 929 | O | ASN | A | 160 | 22.171 | 82.307 | 31.169 | 1.00 | 34.27 | | O |
| ANISOU | 929 | O | ASN | A | 160 | 3313 | 4226 | 5482 | 497 | 1706 | −540 | O |
| ATOM | 930 | CB | ASN | A | 160 | 22.659 | 84.428 | 33.057 | 1.00 | 31.98 | | C |
| ANISOU | 930 | CB | ASN | A | 160 | 2928 | 3995 | 5228 | 372 | 1436 | −267 | C |
| ATOM | 931 | CG | ASN | A | 160 | 23.302 | 85.716 | 33.580 | 1.00 | 41.01 | | C |
| ANISOU | 931 | CG | ASN | A | 160 | 3990 | 5183 | 6410 | 280 | 1395 | −179 | C |
| ATOM | 932 | OD1 | ASN | A | 160 | 23.997 | 86.415 | 32.840 | 1.00 | 53.54 | | O |
| ANISOU | 932 | OD1 | ASN | A | 160 | 5518 | 6819 | 8005 | 206 | 1574 | −206 | O |
| ATOM | 933 | ND2 | ASN | A | 160 | 23.045 | 86.048 | 34.840 | 1.00 | 37.01 | | N |
| ANISOU | 933 | ND2 | ASN | A | 160 | 3490 | 4658 | 5915 | 273 | 1165 | −77 | N |
| ATOM | 934 | N | ASN | A | 161 | 20.376 | 83.415 | 30.378 | 1.00 | 37.30 | | N |
| ANISOU | 934 | N | ASN | A | 161 | 4074 | 4720 | 5377 | 372 | 1692 | −473 | N |
| ATOM | 935 | CA | ASN | A | 161 | 19.896 | 82.331 | 29.532 | 1.00 | 37.10 | | C |
| ANISOU | 935 | CA | ASN | A | 161 | 4135 | 4666 | 5296 | 424 | 1773 | −612 | C |
| ATOM | 936 | C | ASN | A | 161 | 19.593 | 81.049 | 30.309 | 1.00 | 37.96 | | C |
| ANISOU | 936 | C | ASN | A | 161 | 4186 | 4652 | 5584 | 529 | 1625 | −631 | C |
| ATOM | 937 | O | ASN | A | 161 | 19.794 | 79.947 | 29.813 | 1.00 | 39.43 | | O |
| ANISOU | 937 | O | ASN | A | 161 | 4332 | 4771 | 5878 | 600 | 1708 | −769 | O |
| ATOM | 938 | CB | ASN | A | 161 | 20.928 | 82.062 | 28.437 | 1.00 | 37.47 | | C |
| ANISOU | 938 | CB | ASN | A | 161 | 4111 | 4748 | 5379 | 417 | 1991 | −743 | C |
| ATOM | 939 | CG | ASN | A | 161 | 20.362 | 81.270 | 27.288 | 1.00 | 56.24 | | C |
| ANISOU | 939 | CG | ASN | A | 161 | 6644 | 7136 | 7589 | 425 | 2051 | −876 | C |
| ATOM | 940 | OD1 | ASN | A | 161 | 19.203 | 81.456 | 26.915 | 1.00 | 65.98 | | O |
| ANISOU | 940 | OD1 | ASN | A | 161 | 8077 | 8399 | 8592 | 389 | 2005 | −866 | O |
| ATOM | 941 | ND2 | ASN | A | 161 | 21.170 | 80.365 | 26.723 | 1.00 | 58.89 | | N |
| ANISOU | 941 | ND2 | ASN | A | 161 | 6885 | 7442 | 8048 | 474 | 2144 | −1007 | N |
| ATOM | 942 | N | GLU | A | 162 | 19.099 | 81.197 | 31.534 | 1.00 | 34.27 | | N |
| ANISOU | 942 | N | GLU | A | 162 | 3722 | 4151 | 5147 | 533 | 1409 | −494 | N |
| ATOM | 943 | CA | GLU | A | 162 | 18.652 | 80.043 | 32.302 | 1.00 | 31.57 | | C |
| ANISOU | 943 | CA | GLU | A | 162 | 3364 | 3695 | 4936 | 608 | 1259 | −479 | C |
| ATOM | 944 | C | GLU | A | 162 | 17.131 | 79.935 | 32.224 | 1.00 | 36.51 | | C |
| ANISOU | 944 | C | GLU | A | 162 | 4187 | 4327 | 5359 | 574 | 1171 | −461 | C |
| ATOM | 945 | O | GLU | A | 162 | 16.399 | 80.808 | 32.734 | 1.00 | 36.47 | | O |
| ANISOU | 945 | O | GLU | A | 162 | 4269 | 4380 | 5206 | 512 | 1071 | −354 | O |
| ATOM | 946 | CB | GLU | A | 162 | 19.132 | 80.134 | 33.750 | 1.00 | 30.84 | | C |
| ANISOU | 946 | CB | GLU | A | 162 | 3148 | 3561 | 5008 | 628 | 1080 | −339 | C |
| ATOM | 947 | CG | GLU | A | 162 | 20.657 | 80.204 | 33.899 | 1.00 | 39.16 | | C |
| ANISOU | 947 | CG | GLU | A | 162 | 3976 | 4599 | 6305 | 666 | 1133 | −356 | C |
| ATOM | 948 | CD | GLU | A | 162 | 21.107 | 81.174 | 34.982 | 1.00 | 39.05 | | C |
| ANISOU | 948 | CD | GLU | A | 162 | 3891 | 4630 | 6316 | 616 | 995 | −217 | C |
| ATOM | 949 | OE1 | GLU | A | 162 | 22.062 | 80.847 | 35.715 | 1.00 | 37.95 | | O |
| ANISOU | 949 | OE1 | GLU | A | 162 | 3572 | 4432 | 6415 | 668 | 899 | −179 | O |
| ATOM | 950 | OE2 | GLU | A | 162 | 20.496 | 82.257 | 35.115 | 1.00 | 37.99 | | O |
| ANISOU | 950 | OE2 | GLU | A | 162 | 3880 | 4583 | 5972 | 527 | 967 | −151 | O |
| ATOM | 951 | N | ARG | A | 163 | 16.674 | 78.843 | 31.609 | 1.00 | 30.77 | | N |
| ANISOU | 951 | N | ARG | A | 163 | 3512 | 3528 | 4649 | 617 | 1207 | −578 | N |
| ATOM | 952 | CA | ARG | A | 163 | 15.280 | 78.673 | 31.236 | 1.00 | 34.51 | | C |
| ANISOU | 952 | CA | ARG | A | 163 | 4159 | 4009 | 4943 | 580 | 1151 | −601 | C |
| ATOM | 953 | C | ARG | A | 163 | 14.496 | 77.716 | 32.134 | 1.00 | 32.60 | | C |
| ANISOU | 953 | C | ARG | A | 163 | 3928 | 3656 | 4804 | 606 | 993 | −547 | C |
| ATOM | 954 | O | ARG | A | 163 | 14.924 | 76.609 | 32.408 | 1.00 | 39.24 | | O |
| ANISOU | 954 | O | ARG | A | 163 | 4684 | 4372 | 5856 | 675 | 975 | −580 | O |
| ATOM | 955 | CB | ARG | A | 163 | 15.222 | 78.193 | 29.777 | 1.00 | 40.44 | | C |
| ANISOU | 955 | CB | ARG | A | 163 | 4991 | 4771 | 5605 | 586 | 1305 | −787 | C |
| ATOM | 956 | CG | ARG | A | 163 | 13.827 | 78.106 | 29.184 | 1.00 | 41.07 | | C |
| ANISOU | 956 | CG | ARG | A | 163 | 5251 | 4872 | 5483 | 539 | 1243 | −830 | C |
| ATOM | 957 | CD | ARG | A | 163 | 13.851 | 77.536 | 27.771 | 1.00 | 38.26 | | C |
| ANISOU | 957 | CD | ARG | A | 163 | 4983 | 4524 | 5032 | 542 | 1383 | −1029 | C |
| ATOM | 958 | NE | ARG | A | 163 | 14.555 | 78.415 | 26.834 | 1.00 | 47.03 | | N |
| ANISOU | 958 | NE | ARG | A | 163 | 6132 | 5758 | 5979 | 497 | 1555 | −1067 | N |
| ATOM | 959 | CZ | ARG | A | 163 | 13.969 | 79.338 | 26.068 | 1.00 | 46.97 | | C |
| ANISOU | 959 | CZ | ARG | A | 163 | 6289 | 5864 | 5693 | 415 | 1559 | −1040 | C |
| ATOM | 960 | NH1 | ARG | A | 163 | 12.657 | 79.531 | 26.129 | 1.00 | 43.23 | | N |
| ANISOU | 960 | NH1 | ARG | A | 163 | 5936 | 5397 | 5091 | 381 | 1391 | −988 | N |
| ATOM | 961 | NH2 | ARG | A | 163 | 14.700 | 80.077 | 25.242 | 1.00 | 47.31 | | N |
| ANISOU | 961 | NH2 | ARG | A | 163 | 6368 | 6012 | 5598 | 363 | 1719 | −1054 | N |
| ATOM | 962 | N | VAL | A | 164 | 13.328 | 78.153 | 32.575 | 1.00 | 32.75 | | N |
| ANISOU | 962 | N | VAL | A | 164 | 4047 | 3714 | 4684 | 547 | 884 | −463 | N |
| ATOM | 963 | CA | VAL | A | 164 | 12.399 | 77.284 | 33.282 | 1.00 | 33.14 | | C |
| ANISOU | 963 | CA | VAL | A | 164 | 4125 | 3670 | 4795 | 545 | 762 | −419 | C |
| ATOM | 964 | C | VAL | A | 164 | 11.058 | 77.372 | 32.560 | 1.00 | 30.85 | | C |
| ANISOU | 964 | C | VAL | A | 164 | 3968 | 3416 | 4337 | 493 | 747 | −485 | C |
| ATOM | 965 | O | VAL | A | 164 | 10.609 | 78.461 | 32.210 | 1.00 | 26.51 | | O |
| ANISOU | 965 | O | VAL | A | 164 | 3488 | 2977 | 3609 | 446 | 751 | −467 | O |
| ATOM | 966 | CB | VAL | A | 164 | 12.251 | 77.661 | 34.780 | 1.00 | 41.13 | | C |
| ANISOU | 966 | CB | VAL | A | 164 | 5107 | 4692 | 5829 | 516 | 634 | −243 | C |
| ATOM | 967 | CG1 | VAL | A | 164 | 11.340 | 76.663 | 35.491 | 1.00 | 39.06 | | C |
| ANISOU | 967 | CG1 | VAL | A | 164 | 4878 | 4330 | 5634 | 499 | 534 | −190 | C |
| ATOM | 968 | CG2 | VAL | A | 164 | 13.610 | 77.668 | 35.457 | 1.00 | 35.71 | | C |
| ANISOU | 968 | CG2 | VAL | A | 164 | 4289 | 3979 | 5299 | 563 | 618 | −176 | C |
| ATOM | 969 | N | THR | A | 165 | 10.433 | 76.224 | 32.321 | 1.00 | 32.99 | | N |
| ANISOU | 969 | N | THR | A | 165 | 4269 | 3582 | 4683 | 503 | 718 | −562 | N |
| ATOM | 970 | CA | THR | A | 165 | 9.274 | 76.143 | 31.440 | 1.00 | 31.74 | | C |
| ANISOU | 970 | CA | THR | A | 165 | 4221 | 3445 | 4392 | 459 | 701 | −660 | C |
| ATOM | 971 | C | THR | A | 165 | 8.189 | 75.291 | 32.062 | 1.00 | 32.84 | | C |
| ANISOU | 971 | C | THR | A | 165 | 4368 | 3487 | 4623 | 427 | 594 | −629 | C |
| ATOM | 972 | O | THR | A | 165 | 8.460 | 74.242 | 32.622 | 1.00 | 44.46 | | O |
| ANISOU | 972 | O | THR | A | 165 | 5786 | 4826 | 6283 | 455 | 571 | −608 | O |
| ATOM | 973 | CB | THR | A | 165 | 9.671 | 75.565 | 30.065 | 1.00 | 41.42 | | C |
| ANISOU | 973 | CB | THR | A | 165 | 5493 | 4649 | 5595 | 490 | 808 | −854 | C |
| ATOM | 974 | OG1 | THR | A | 165 | 10.478 | 76.518 | 29.368 | 1.00 | 52.48 | | O |
| ANISOU | 974 | OG1 | THR | A | 165 | 6911 | 6168 | 6859 | 490 | 925 | −878 | O |
| ATOM | 975 | CG2 | THR | A | 165 | 8.463 | 75.258 | 29.218 | 1.00 | 30.86 | | C |
| ANISOU | 975 | CG2 | THR | A | 165 | 4272 | 3312 | 4143 | 444 | 755 | −965 | C |
| ATOM | 976 | N | PHE | A | 166 | 6.953 | 75.750 | 31.964 | 1.00 | 35.47 | | N |
| ANISOU | 976 | N | PHE | A | 166 | 4761 | 3879 | 4839 | 365 | 527 | −621 | N |
| ATOM | 977 | CA | PHE | A | 166 | 5.827 | 75.025 | 32.527 | 1.00 | 30.87 | | C |
| ANISOU | 977 | CA | PHE | A | 166 | 4172 | 3216 | 4342 | 315 | 440 | −595 | C |
| ATOM | 978 | C | PHE | A | 166 | 4.517 | 75.575 | 32.002 | 1.00 | 33.55 | | C |
| ANISOU | 978 | C | PHE | A | 166 | 4565 | 3628 | 4555 | 257 | 377 | −641 | C |
| ATOM | 979 | O | PHE | A | 166 | 4.457 | 76.704 | 31.502 | 1.00 | 38.25 | | O |
| ANISOU | 979 | O | PHE | A | 166 | 5202 | 4340 | 4989 | 256 | 379 | −642 | O |
| ATOM | 980 | CB | PHE | A | 166 | 5.846 | 75.119 | 34.042 | 1.00 | 28.51 | | C |
| ANISOU | 980 | CB | PHE | A | 166 | 3814 | 2905 | 4115 | 291 | 403 | −419 | C |
| ATOM | 981 | CG | PHE | A | 166 | 6.030 | 76.532 | 34.556 | 1.00 | 25.17 | | C |
| ANISOU | 981 | CG | PHE | A | 166 | 3383 | 2621 | 3560 | 281 | 408 | −324 | C |
| ATOM | 982 | CD2 | PHE | A | 166 | 7.295 | 77.015 | 34.865 | 1.00 | 24.72 | | C |
| ANISOU | 982 | CD2 | PHE | A | 166 | 3288 | 2598 | 3507 | 326 | 447 | −267 | C |
| ATOM | 983 | CD1 | PHE | A | 166 | 4.939 | 77.370 | 34.743 | 1.00 | 26.56 | | C |
| ANISOU | 983 | CD1 | PHE | A | 166 | 3577 | 2882 | 3633 | 228 | 370 | −301 | C |
| ATOM | 984 | CE2 | PHE | A | 166 | 7.474 | 78.314 | 35.349 | 1.00 | 18.15 | | C |
| ANISOU | 984 | CE2 | PHE | A | 166 | 2450 | 1880 | 2567 | 309 | 445 | −190 | C |
| ATOM | 985 | CE1 | PHE | A | 166 | 5.116 | 78.668 | 35.226 | 1.00 | 22.77 | | C |
| ANISOU | 985 | CE1 | PHE | A | 166 | 3091 | 2510 | 3052 | 223 | 374 | −229 | C |
| ATOM | 986 | CZ | PHE | A | 166 | 6.387 | 79.130 | 35.521 | 1.00 | 21.99 | | C |
| ANISOU | 986 | CZ | PHE | A | 166 | 2968 | 2439 | 2947 | 259 | 410 | −174 | C |
| ATOM | 987 | N | ARG | A | 167 | 3.470 | 74.771 | 32.109 | 1.00 | 30.16 | | N |
| ANISOU | 987 | N | ARG | A | 167 | 4128 | 3118 | 4215 | 208 | 313 | −674 | N |
| ATOM | 988 | CA | ARG | A | 167 | 2.136 | 75.221 | 31.754 | 1.00 | 28.18 | | C |
| ANISOU | 988 | CA | ARG | A | 167 | 3892 | 2923 | 3892 | 152 | 231 | −712 | C |
| ATOM | 989 | C | ARG | A | 167 | 1.496 | 75.935 | 32.914 | 1.00 | 26.63 | | C |
| ANISOU | 989 | C | ARG | A | 167 | 3632 | 2785 | 3702 | 110 | 211 | −578 | C |
| ATOM | 990 | O | ARG | A | 167 | 1.675 | 75.546 | 34.055 | 1.00 | 30.08 | | O |
| ANISOU | 990 | O | ARG | A | 167 | 4022 | 3176 | 4232 | 89 | 238 | −471 | O |
| ATOM | 991 | CB | ARG | A | 167 | 1.258 | 74.063 | 31.310 | 1.00 | 24.40 | | C |
| ANISOU | 991 | CB | ARG | A | 167 | 3416 | 2332 | 3524 | 106 | 170 | −824 | C |
| ATOM | 992 | CG | ARG | A | 167 | 1.755 | 73.468 | 30.043 | 1.00 | 35.47 | | C |
| ANISOU | 992 | CG | ARG | A | 167 | 4897 | 3691 | 4889 | 142 | 188 | −993 | C |
| ATOM | 993 | CD | ARG | A | 167 | 0.778 | 72.493 | 29.454 | 1.00 | 43.31 | | C |
| ANISOU | 993 | CD | ARG | A | 167 | 5905 | 4587 | 5966 | 88 | 104 | −1131 | C |
| ATOM | 994 | NE | ARG | A | 167 | 0.187 | 73.025 | 28.233 | 1.00 | 42.75 | | N |
| ANISOU | 994 | NE | ARG | A | 167 | 5917 | 4608 | 5717 | 72 | 24 | −1252 | N |
| ATOM | 995 | CZ | ARG | A | 167 | −1.074 | 73.400 | 28.161 | 1.00 | 42.89 | | C |
| ANISOU | 995 | CZ | ARG | A | 167 | 5907 | 4667 | 5724 | 15 | −100 | −1252 | C |
| ATOM | 996 | NH1 | ARG | A | 167 | −1.834 | 73.268 | 29.235 | 1.00 | 51.53 | | N |
| ANISOU | 996 | NH1 | ARG | A | 167 | 6885 | 5720 | 6975 | −35 | −122 | −1151 | N |
| ATOM | 997 | NH2 | ARG | A | 167 | −1.572 | 73.877 | 27.033 | 1.00 | 38.82 | | N |
| ANISOU | 997 | NH2 | ARG | A | 167 | 5476 | 4230 | 5046 | 5 | −201 | −1350 | N |
| ATOM | 998 | N | LYS | A | 168 | 0.782 | 77.011 | 32.619 | 1.00 | 25.17 | | N |
| ANISOU | 998 | N | LYS | A | 168 | 3451 | 2700 | 3410 | 99 | 162 | −586 | N |
| ATOM | 999 | CA | LYS | A | 168 | 0.008 | 77.677 | 33.641 | 1.00 | 25.91 | | C |
| ANISOU | 999 | CA | LYS | A | 168 | 3474 | 2845 | 3525 | 59 | 151 | −498 | C |
| ATOM | 1000 | C | LYS | A | 168 | −1.401 | 77.998 | 33.162 | 1.00 | 30.91 | | C |
| ANISOU | 1000 | C | LYS | A | 168 | 4071 | 3502 | 4170 | 24 | 58 | −569 | C |
| ATOM | 1001 | O | LYS | A | 168 | −1.608 | 78.278 | 31.978 | 1.00 | 29.02 | | O |
| ANISOU | 1001 | O | LYS | A | 168 | 3890 | 3287 | 3849 | 47 | −19 | −656 | O |
| ATOM | 1002 | CB | LYS | A | 168 | 0.691 | 78.979 | 34.095 | 1.00 | 35.44 | | C |
| ANISOU | 1002 | CB | LYS | A | 168 | 4689 | 4149 | 4626 | 96 | 190 | −413 | C |
| ATOM | 1003 | CG | LYS | A | 168 | 0.155 | 79.414 | 35.451 | 1.00 | 33.01 | | C |
| ANISOU | 1003 | CG | LYS | A | 168 | 4311 | 3877 | 4356 | 54 | 214 | −326 | C |
| ATOM | 1004 | CD | LYS | A | 168 | 0.406 | 80.812 | 35.824 | 1.00 | 27.63 | | C |
| ANISOU | 1004 | CD | LYS | A | 168 | 3628 | 3285 | 3584 | 78 | 226 | −280 | C |
| ATOM | 1005 | CE | LYS | A | 168 | −0.227 | 81.054 | 37.180 | 1.00 | 32.23 | | C |
| ANISOU | 1005 | CE | LYS | A | 168 | 4144 | 3898 | 4203 | 26 | 266 | −226 | C |
| ATOM | 1006 | NZ | LYS | A | 168 | −1.591 | 80.450 | 37.290 | 1.00 | 28.69 | | N |
| ANISOU | 1006 | NZ | LYS | A | 168 | 3624 | 3419 | 3858 | −34 | 254 | −273 | N |
| ATOM | 1007 | N | LEU | A | 169 | −2.350 | 77.979 | 34.099 | 1.00 | 19.81 | | N |
| ANISOU | 1007 | N | LEU | A | 169 | 2569 | 2095 | 2863 | −33 | 64 | −530 | N |
| ATOM | 1008 | CA | LEU | A | 169 | −3.713 | 78.429 | 33.846 | 1.00 | 27.87 | | C |
| ANISOU | 1008 | CA | LEU | A | 169 | 3512 | 3145 | 3934 | −61 | −18 | −590 | C |
| ATOM | 1009 | C | LEU | A | 169 | −3.737 | 79.943 | 33.931 | 1.00 | 23.53 | | C |
| ANISOU | 1009 | C | LEU | A | 169 | 2956 | 2691 | 3294 | −12 | −34 | −557 | C |
| ATOM | 1010 | O | LEU | A | 169 | −3.545 | 80.493 | 35.005 | 1.00 | 22.81 | | O |
| ANISOU | 1010 | O | LEU | A | 169 | 2827 | 2641 | 3199 | −16 | 49 | −482 | O |
| ATOM | 1011 | CB | LEU | A | 169 | −4.703 | 77.840 | 34.868 | 1.00 | 20.98 | | C |
| ANISOU | 1011 | CB | LEU | A | 169 | 2519 | 2235 | 3217 | −151 | 28 | −567 | C |
| ATOM | 1012 | CG | LEU | A | 169 | −6.174 | 78.030 | 34.480 | 1.00 | 29.43 | | C |
| ANISOU | 1012 | CG | LEU | A | 169 | 3475 | 3312 | 4397 | −186 | −65 | −657 | C |
| ATOM | 1013 | CD1 | LEU | A | 169 | −6.482 | 77.342 | 33.163 | 1.00 | 26.03 | | C |
| ANISOU | 1013 | CD1 | LEU | A | 169 | 3083 | 2819 | 3988 | −188 | −198 | −774 | C |
| ATOM | 1014 | CD2 | LEU | A | 169 | −7.111 | 77.551 | 35.558 | 1.00 | 34.45 | | C |
| ANISOU | 1014 | CD2 | LEU | A | 169 | 3976 | 3926 | 5188 | −285 | 19 | −632 | C |
| ATOM | 1015 | N | MET | A | 170 | −4.012 | 80.603 | 32.809 | 1.00 | 26.34 | | N |
| ANISOU | 1015 | N | MET | A | 170 | 3353 | 3074 | 3579 | 30 | −148 | −614 | N |
| ATOM | 1016 | CA | MET | A | 170 | −3.922 | 82.057 | 32.723 | 1.00 | 19.38 | | C |
| ANISOU | 1016 | CA | MET | A | 170 | 2489 | 2258 | 2618 | 83 | −181 | −574 | C |
| ATOM | 1017 | C | MET | A | 170 | −5.242 | 82.690 | 32.280 | 1.00 | 35.16 | | C |
| ANISOU | 1017 | C | MET | A | 170 | 4406 | 4262 | 4691 | 93 | −322 | −629 | C |
| ATOM | 1018 | O | MET | A | 170 | −6.112 | 82.008 | 31.737 | 1.00 | 37.13 | | O |
| ANISOU | 1018 | O | MET | A | 170 | 4611 | 4475 | 5020 | 62 | −418 | −708 | O |
| ATOM | 1019 | CB | MET | A | 170 | −2.813 | 82.454 | 31.768 | 1.00 | 24.85 | | C |
| ANISOU | 1019 | CB | MET | A | 170 | 3328 | 2974 | 3138 | 129 | −190 | −556 | C |
| ATOM | 1020 | CG | MET | A | 170 | −1.445 | 82.046 | 32.243 | 1.00 | 26.49 | | C |
| ANISOU | 1020 | CG | MET | A | 170 | 3585 | 3180 | 3301 | 134 | −55 | −502 | C |
| ATOM | 1021 | SD | MET | A | 170 | −0.219 | 82.236 | 30.962 | 1.00 | 33.42 | | S |
| ANISOU | 1021 | SD | MET | A | 170 | 4614 | 4083 | 4002 | 170 | −38 | −515 | S |
| ATOM | 1022 | CE | MET | A | 170 | −0.619 | 80.850 | 29.935 | 1.00 | 20.68 | | C |
| ANISOU | 1022 | CE | MET | A | 170 | 3048 | 2412 | 2396 | 146 | −91 | −647 | C |
| ATOM | 1023 | N | GLY | A | 171 | −5.408 | 83.986 | 32.550 | 1.00 | 28.39 | | N |
| ANISOU | 1023 | N | GLY | A | 171 | 3517 | 3437 | 3830 | 139 | −343 | −592 | N |
| ATOM | 1024 | CA | GLY | A | 171 | −6.629 | 84.665 | 32.178 | 1.00 | 21.09 | | C |
| ANISOU | 1024 | CA | GLY | A | 171 | 2500 | 2504 | 3011 | 165 | −488 | −640 | C |
| ATOM | 1025 | C | GLY | A | 171 | −6.496 | 85.497 | 30.921 | 1.00 | 31.16 | | C |
| ANISOU | 1025 | C | GLY | A | 171 | 3893 | 3781 | 4165 | 220 | −651 | −619 | C |
| ATOM | 1026 | O | GLY | A | 171 | −5.549 | 86.272 | 30.762 | 1.00 | 29.94 | | O |
| ANISOU | 1026 | O | GLY | A | 171 | 3853 | 3647 | 3876 | 252 | −617 | −544 | O |
| ATOM | 1027 | N | CYS | A | 172 | −7.455 | 85.345 | 30.020 | 1.00 | 26.59 | | N |
| ANISOU | 1027 | N | CYS | A | 172 | 3290 | 3180 | 3634 | 222 | −838 | −679 | N |
| ATOM | 1028 | CA | CYS | A | 172 | −7.591 | 86.279 | 28.918 | 1.00 | 30.63 | | C |
| ANISOU | 1028 | CA | CYS | A | 172 | 3901 | 3688 | 4049 | 272 | −1029 | −644 | C |
| ATOM | 1029 | C | CYS | A | 172 | −8.489 | 87.446 | 29.328 | 1.00 | 36.78 | | C |
| ANISOU | 1029 | C | CYS | A | 172 | 4537 | 4435 | 5003 | 333 | −1122 | −633 | C |
| ATOM | 1030 | O | CYS | A | 172 | −9.631 | 87.219 | 29.723 | 1.00 | 37.49 | | O |
| ANISOU | 1030 | O | CYS | A | 172 | 4436 | 4501 | 5307 | 329 | −1169 | −710 | O |
| ATOM | 1031 | CB | CYS | A | 172 | −8.162 | 85.571 | 27.693 | 1.00 | 37.20 | | C |
| ANISOU | 1031 | CB | CYS | A | 172 | 4794 | 4512 | 4829 | 245 | −1218 | −715 | C |
| ATOM | 1032 | SG | CYS | A | 172 | −6.911 | 84.635 | 26.782 | 1.00 | 50.78 | | S |
| ANISOU | 1032 | SG | CYS | A | 172 | 6749 | 6266 | 6278 | 199 | −1139 | −731 | S |
| ATOM | 1033 | N | HIS | A | 173 | −7.976 | 88.679 | 29.259 | 1.00 | 24.42 | | N |
| ANISOU | 1033 | N | HIS | A | 173 | 3051 | 2860 | 3369 | 387 | −1139 | −543 | N |
| ATOM | 1034 | CA | HIS | A | 173 | −8.832 | 89.858 | 29.450 | 1.00 | 27.36 | | C |
| ANISOU | 1034 | CA | HIS | A | 173 | 3302 | 3175 | 3917 | 461 | −1262 | −537 | C |
| ATOM | 1035 | C | HIS | A | 173 | −9.745 | 90.025 | 28.230 | 1.00 | 37.35 | | C |
| ANISOU | 1035 | C | HIS | A | 173 | 4583 | 4403 | 5207 | 491 | −1557 | −542 | C |
| ATOM | 1036 | O | HIS | A | 173 | −9.267 | 90.135 | 27.093 | 1.00 | 33.95 | | O |
| ANISOU | 1036 | O | HIS | A | 173 | 4358 | 3982 | 4560 | 482 | −1679 | −470 | O |
| ATOM | 1037 | CB | HIS | A | 173 | −8.011 | 91.152 | 29.655 | 1.00 | 28.70 | | C |
| ANISOU | 1037 | CB | HIS | A | 173 | 3566 | 3321 | 4018 | 506 | −1218 | −437 | C |
| ATOM | 1038 | CG | HIS | A | 173 | −7.050 | 91.110 | 30.808 | 1.00 | 29.80 | | C |
| ANISOU | 1038 | CG | HIS | A | 173 | 3704 | 3498 | 4121 | 477 | −964 | −428 | C |
| ATOM | 1039 | ND1 | HIS | A | 173 | −6.181 | 92.146 | 31.083 | 1.00 | 22.37 | | N |
| ANISOU | 1039 | ND1 | HIS | A | 173 | 2844 | 2538 | 3118 | 498 | −902 | −350 | N |
| ATOM | 1040 | CD2 | HIS | A | 173 | −6.809 | 90.163 | 31.752 | 1.00 | 27.44 | | C |
| ANISOU | 1040 | CD2 | HIS | A | 173 | 3338 | 3250 | 3837 | 422 | −774 | −479 | C |
| ATOM | 1041 | CE1 | HIS | A | 173 | −5.459 | 91.846 | 32.149 | 1.00 | 28.52 | | C |
| ANISOU | 1041 | CE1 | HIS | A | 173 | 3600 | 3362 | 3874 | 461 | −696 | −365 | C |
| ATOM | 1042 | NE2 | HIS | A | 173 | −5.815 | 90.641 | 32.571 | 1.00 | 22.44 | | N |
| ANISOU | 1042 | NE2 | HIS | A | 173 | 2749 | 2636 | 3142 | 416 | −617 | −434 | N |
| ATOM | 1043 | N | MET | A | 174 | −11.053 | 90.067 | 28.463 | 1.00 | 36.03 | | N |
| ANISOU | 1043 | N | MET | A | 174 | 4197 | 4193 | 5300 | 523 | −1673 | −625 | N |
| ATOM | 1044 | CA | MET | A | 174 | −11.982 | 90.421 | 27.397 | 1.00 | 33.06 | | C |
| ANISOU | 1044 | CA | MET | A | 174 | 3808 | 3766 | 4987 | 568 | −1990 | −621 | C |
| ATOM | 1045 | C | MET | A | 174 | −12.604 | 91.780 | 27.717 | 1.00 | 39.57 | | C |
| ANISOU | 1045 | C | MET | A | 174 | 4497 | 4502 | 6035 | 673 | −2097 | −597 | C |
| ATOM | 1046 | O | MET | A | 174 | −13.233 | 92.396 | 26.868 | 1.00 | 44.47 | | O |
| ANISOU | 1046 | O | MET | A | 174 | 5126 | 5057 | 6713 | 733 | −2382 | −554 | O |
| ATOM | 1047 | CB | MET | A | 174 | −13.076 | 89.356 | 27.199 | 1.00 | 32.31 | | C |
| ANISOU | 1047 | CB | MET | A | 174 | 3551 | 3676 | 5049 | 524 | −2096 | −746 | C |
| ATOM | 1048 | CG | MET | A | 174 | −12.578 | 88.005 | 26.678 | 1.00 | 31.83 | | C |
| ANISOU | 1048 | CG | MET | A | 174 | 3633 | 3675 | 4787 | 425 | −2045 | −785 | C |
| ATOM | 1049 | SD | MET | A | 174 | −11.351 | 88.153 | 25.360 | 1.00 | 56.38 | | S |
| ANISOU | 1049 | SD | MET | A | 174 | 7111 | 6827 | 7485 | 408 | −2116 | −675 | S |
| ATOM | 1050 | CE | MET | A | 174 | −12.387 | 88.205 | 23.913 | 1.00 | 34.82 | | C |
| ANISOU | 1050 | CE | MET | A | 174 | 4428 | 4071 | 4729 | 417 | −2524 | −693 | C |
| ATOM | 1051 | N | AHIS | A | 175 | −12.440 | 92.231 | 28.958 | 0.49 | 36.57 | | N |
| ANISOU | 1051 | N | AHIS | A | 175 | 3995 | 4113 | 5786 | 696 | −1876 | −630 | N |
| ATOM | 1052 | CA | AHIS | A | 175 | −12.916 | 93.547 | 29.377 | 0.49 | 35.71 | | C |
| ANISOU | 1052 | CA | AHIS | A | 175 | 3761 | 3910 | 5898 | 800 | −1937 | −629 | C |
| ATOM | 1053 | C | AHIS | A | 175 | −11.899 | 94.170 | 30.322 | 0.49 | 37.34 | | C |
| ANISOU | 1053 | C | AHIS | A | 175 | 4035 | 4124 | 6028 | 800 | −1692 | −596 | C |
| ATOM | 1054 | O | AHIS | A | 175 | −11.557 | 93.577 | 31.347 | 0.49 | 39.45 | | O |
| ANISOU | 1054 | O | AHIS | A | 175 | 4248 | 4463 | 6276 | 740 | −1434 | −660 | O |
| ATOM | 1055 | CB | AHIS | A | 175 | −14.283 | 93.446 | 30.058 | 0.49 | 33.28 | | C |
| ANISOU | 1055 | CB | AHIS | A | 175 | 3126 | 3572 | 5949 | 837 | −1940 | −782 | C |
| ATOM | 1056 | CG | AHIS | A | 175 | −14.772 | 94.737 | 30.646 | 0.49 | 44.80 | | C |
| ANISOU | 1056 | CG | AHIS | A | 175 | 4424 | 4928 | 7668 | 950 | −1955 | −820 | C |
| ATOM | 1057 | ND1 | AHIS | A | 175 | −15.431 | 95.694 | 29.902 | 0.49 | 44.56 | | N |
| ANISOU | 1057 | ND1 | AHIS | A | 175 | 4379 | 4778 | 7775 | 1037 | −2218 | −773 | N |
| ATOM | 1058 | CD2 | AHIS | A | 175 | −14.698 | 95.228 | 31.906 | 0.49 | 41.53 | | C |
| ANISOU | 1058 | CD2 | AHIS | A | 175 | 3889 | 4511 | 7379 | 969 | −1713 | −904 | C |
| ATOM | 1059 | CE1 | AHIS | A | 175 | −15.746 | 96.713 | 30.680 | 0.49 | 37.27 | | C |
| ANISOU | 1059 | CE1 | AHIS | A | 175 | 3338 | 3775 | 7048 | 1096 | −2115 | −831 | C |
| ATOM | 1060 | NE2 | AHIS | A | 175 | −15.314 | 96.456 | 31.900 | 0.49 | 35.60 | | N |
| ANISOU | 1060 | NE2 | AHIS | A | 175 | 3040 | 3633 | 6853 | 1074 | −1831 | −924 | N |
| ATOM | 1061 | N | BHIS | A | 175 | −12.404 | 92.236 | 28.948 | 0.51 | 36.46 | | N |
| ANISOU | 1061 | N | BHIS | A | 175 | 3988 | 4100 | 5763 | 695 | −1874 | −626 | N |
| ATOM | 1062 | CA | BHIS | A | 175 | −12.902 | 93.528 | 29.387 | 0.51 | 35.72 | | C |
| ANISOU | 1062 | CA | BHIS | A | 175 | 3763 | 3913 | 5896 | 798 | −1932 | −630 | C |
| ATOM | 1063 | C | BHIS | A | 175 | −11.875 | 94.159 | 30.317 | 0.51 | 37.31 | | C |
| ANISOU | 1063 | C | BHIS | A | 175 | 4036 | 4123 | 6019 | 798 | −1690 | −594 | C |
| ATOM | 1064 | O | BHIS | A | 175 | −11.510 | 93.563 | 31.332 | 0.51 | 39.35 | | O |
| ANISOU | 1064 | O | BHIS | A | 175 | 4245 | 4454 | 6253 | 738 | −1432 | −656 | O |
| ATOM | 1065 | CB | BHIS | A | 175 | −14.246 | 93.386 | 30.102 | 0.51 | 33.17 | | C |
| ANISOU | 1065 | CB | BHIS | A | 175 | 3113 | 3563 | 5925 | 831 | −1923 | −784 | C |
| ATOM | 1066 | CG | BHIS | A | 175 | −15.314 | 92.740 | 29.275 | 0.51 | 40.63 | | C |
| ANISOU | 1066 | CG | BHIS | A | 175 | 3949 | 4498 | 6992 | 824 | −2166 | −836 | C |
| ATOM | 1067 | ND1 | BHIS | A | 175 | −16.272 | 93.467 | 28.593 | 0.51 | 42.65 | | N |
| ANISOU | 1067 | ND1 | BHIS | A | 175 | 4129 | 4653 | 7425 | 902 | −2433 | −825 | N |
| ATOM | 1068 | CD2 | BHIS | A | 175 | −15.588 | 91.436 | 29.028 | 0.51 | 35.07 | | C |
| ANISOU | 1068 | CD2 | BHIS | A | 175 | 3220 | 3858 | 6247 | 730 | −2161 | −897 | C |
| ATOM | 1069 | CE1 | BHIS | A | 175 | −17.083 | 92.637 | 27.965 | 0.51 | 38.99 | | C |
| ANISOU | 1069 | CE1 | BHIS | A | 175 | 3611 | 4202 | 7001 | 850 | −2562 | −875 | C |
| ATOM | 1070 | NE2 | BHIS | A | 175 | −16.691 | 91.398 | 28.214 | 0.51 | 37.50 | | N |
| ANISOU | 1070 | NE2 | BHIS | A | 175 | 3418 | 4113 | 6717 | 759 | −2446 | −933 | N |
| ATOM | 1071 | N | GLU | A | 176 | −11.401 | 95.351 | 29.966 | 1.00 | 34.96 | | N |
| ANISOU | 1071 | N | GLU | A | 176 | 3862 | 3745 | 5678 | 857 | −1784 | −488 | N |
| ATOM | 1072 | CA | GLU | A | 176 | −10.476 | 96.091 | 30.821 | 1.00 | 34.27 | | C |
| ANISOU | 1072 | CA | GLU | A | 176 | 3830 | 3644 | 5546 | 859 | −1587 | −463 | C |
| ATOM | 1073 | C | GLU | A | 176 | −11.074 | 97.458 | 31.183 | 1.00 | 34.40 | | C |
| ANISOU | 1073 | C | GLU | A | 176 | 3718 | 3522 | 5829 | 971 | −1675 | −493 | C |
| ATOM | 1074 | O | GLU | A | 176 | −12.069 | 97.869 | 30.605 | 1.00 | 32.71 | | O |
| ANISOU | 1074 | O | GLU | A | 176 | 3403 | 3216 | 5809 | 1052 | −1914 | −499 | O |
| ATOM | 1075 | CB | GLU | A | 176 | −9.110 | 96.265 | 30.148 | 1.00 | 33.58 | | C |
| ANISOU | 1075 | CB | GLU | A | 176 | 4024 | 3580 | 5155 | 807 | −1571 | −307 | C |
| ATOM | 1076 | CG | GLU | A | 176 | −8.239 | 95.030 | 30.186 | 1.00 | 29.92 | | C |
| ANISOU | 1076 | CG | GLU | A | 176 | 3666 | 3246 | 4456 | 705 | −1393 | −306 | C |
| ATOM | 1077 | CD | GLU | A | 176 | −6.908 | 95.215 | 29.467 | 1.00 | 39.19 | | C |
| ANISOU | 1077 | CD | GLU | A | 176 | 5093 | 4443 | 5353 | 654 | −1365 | −167 | C |
| ATOM | 1078 | OE1 | GLU | A | 176 | −6.749 | 96.202 | 28.711 | 1.00 | 38.60 | | O |
| ANISOU | 1078 | OE1 | GLU | A | 176 | 5141 | 4291 | 5234 | 684 | −1515 | −51 | O |
| ATOM | 1079 | OE2 | GLU | A | 176 | −6.011 | 94.369 | 29.671 | 1.00 | 42.67 | | O |
| ANISOU | 1079 | OE2 | GLU | A | 176 | 5605 | 4976 | 5633 | 583 | −1187 | −171 | O |
| ATOM | 1080 | N | GLU | A | 177 | −10.439 | 98.175 | 32.102 | 1.00 | 34.14 | | N |
| ANISOU | 1080 | N | GLU | A | 177 | 3694 | 3465 | 5812 | 978 | −1500 | −513 | N |
| ATOM | 1081 | CA | GLU | A | 177 | −11.120 | 99.271 | 32.791 | 1.00 | 39.42 | | C |
| ANISOU | 1081 | CA | GLU | A | 177 | 4185 | 4012 | 6779 | 1080 | −1510 | −613 | C |
| ATOM | 1082 | C | GLU | A | 177 | −10.161 | 100.290 | 33.379 | 1.00 | 36.91 | | C |
| ANISOU | 1082 | C | GLU | A | 177 | 3972 | 3635 | 6419 | 1083 | −1396 | −585 | C |
| ATOM | 1083 | O | GLU | A | 177 | −9.084 | 99.930 | 33.845 | 1.00 | 34.71 | | O |
| ANISOU | 1083 | O | GLU | A | 177 | 3815 | 3451 | 5922 | 994 | −1206 | −557 | O |
| ATOM | 1084 | CB | GLU | A | 177 | −11.949 | 98.697 | 33.931 | 1.00 | 34.72 | | C |
| ANISOU | 1084 | CB | GLU | A | 177 | 3337 | 3487 | 6366 | 1072 | −1318 | −812 | C |
| ATOM | 1085 | CG | GLU | A | 177 | −13.365 | 99.103 | 33.987 | 1.00 | 38.34 | | C |
| ANISOU | 1085 | CG | GLU | A | 177 | 3539 | 3857 | 7172 | 1168 | −1432 | −934 | C |
| ATOM | 1086 | CD | GLU | A | 177 | −14.086 | 98.355 | 35.082 | 1.00 | 51.46 | | C |
| ANISOU | 1086 | CD | GLU | A | 177 | 4982 | 5622 | 8950 | 1113 | −1191 | −1115 | C |
| ATOM | 1087 | OE1 | GLU | A | 177 | −13.612 | 98.411 | 36.246 | 1.00 | 39.73 | | O |
| ANISOU | 1087 | OE1 | GLU | A | 177 | 3481 | 4194 | 7419 | 1080 | −931 | −1201 | O |
| ATOM | 1088 | OE2 | GLU | A | 177 | −15.107 | 97.695 | 34.776 | 1.00 | 64.05 | | O |
| ANISOU | 1088 | OE2 | GLU | A | 177 | 6434 | 7240 | 10661 | 1090 | −1258 | −1164 | O |
| ATOM | 1089 | N | SER | A | 178 | −10.570 | 101.552 | 33.377 | 1.00 | 38.58 | | N |
| ANISOU | 1089 | N | SER | A | 178 | 4121 | 3677 | 6862 | 1188 | −1522 | −598 | N |
| ATOM | 1090 | CA | SER | A | 178 | −9.894 | 102.592 | 34.149 | 1.00 | 32.13 | | C |
| ANISOU | 1090 | CA | SER | A | 178 | 3344 | 2778 | 6086 | 1202 | −1404 | −629 | C |
| ATOM | 1091 | C | SER | A | 178 | −8.394 | 102.676 | 33.869 | 1.00 | 30.67 | | C |
| ANISOU | 1091 | C | SER | A | 178 | 3419 | 2630 | 5604 | 1104 | −1344 | −469 | C |
| ATOM | 1092 | O | SER | A | 178 | −7.993 | 102.917 | 32.736 | 1.00 | 38.09 | | O |
| ANISOU | 1092 | O | SER | A | 178 | 4534 | 3517 | 6423 | 1092 | −1515 | −286 | O |
| ATOM | 1093 | CB | SER | A | 178 | −10.150 | 102.341 | 35.632 | 1.00 | 49.26 | | C |
| ANISOU | 1093 | CB | SER | A | 178 | 5340 | 5032 | 8346 | 1185 | −1133 | −846 | C |
| ATOM | 1094 | OG | SER | A | 178 | −11.534 | 102.066 | 35.850 | 1.00 | 54.65 | | O |
| ANISOU | 1094 | OG | SER | A | 178 | 5788 | 5731 | 9243 | 1219 | −1136 | −982 | O |
| ATOM | 1095 | N | LEU | A | 179 | −7.571 | 102.479 | 34.892 | 1.00 | 28.92 | | N |
| ANISOU | 1095 | N | LEU | A | 179 | 3222 | 2500 | 5266 | 1030 | −1102 | −537 | N |
| ATOM | 1096 | CA | LEU | A | 179 | −6.126 | 102.549 | 34.730 | 1.00 | 27.52 | | C |
| ANISOU | 1096 | CA | LEU | A | 179 | 3254 | 2361 | 4844 | 937 | −1031 | −405 | C |
| ATOM | 1097 | C | LEU | A | 179 | −5.580 | 101.575 | 33.677 | 1.00 | 26.71 | | C |
| ANISOU | 1097 | C | LEU | A | 179 | 3305 | 2365 | 4480 | 862 | −1073 | −253 | C |
| ATOM | 1098 | O | LEU | A | 179 | −4.553 | 101.855 | 33.063 | 1.00 | 30.87 | | O |
| ANISOU | 1098 | O | LEU | A | 179 | 4011 | 2878 | 4840 | 805 | −1089 | −107 | O |
| ATOM | 1099 | CB | LEU | A | 179 | −5.433 | 102.299 | 36.076 | 1.00 | 32.42 | | C |
| ANISOU | 1099 | CB | LEU | A | 179 | 3849 | 3085 | 5386 | 868 | −781 | −520 | C |
| ATOM | 1100 | CG | LEU | A | 179 | −5.626 | 103.439 | 37.090 | 1.00 | 41.95 | | C |
| ANISOU | 1100 | CG | LEU | A | 179 | 4964 | 4180 | 6795 | 920 | −723 | −667 | C |
| ATOM | 1101 | CD1 | LEU | A | 179 | −5.085 | 103.102 | 38.484 | 1.00 | 26.12 | | C |
| ANISOU | 1101 | CD1 | LEU | A | 179 | 2935 | 2299 | 4690 | 846 | −486 | −798 | C |
| ATOM | 1102 | CD2 | LEU | A | 179 | −4.993 | 104.751 | 36.559 | 1.00 | 34.18 | | C |
| ANISOU | 1102 | CD2 | LEU | A | 179 | 4104 | 3014 | 5868 | 940 | −852 | −554 | C |
| ATOM | 1103 | N | PHE | A | 180 | −6.234 | 100.427 | 33.482 | 1.00 | 28.66 | | N |
| ANISOU | 1103 | N | PHE | A | 180 | 3479 | 2718 | 4694 | 853 | −1076 | −299 | N |
| ATOM | 1104 | CA | PHE | A | 180 | −5.779 | 99.461 | 32.478 | 1.00 | 25.50 | | C |
| ANISOU | 1104 | CA | PHE | A | 180 | 3221 | 2413 | 4056 | 786 | −1113 | −186 | C |
| ATOM | 1105 | C | PHE | A | 180 | −5.898 | 100.014 | 31.057 | 1.00 | 29.84 | | C |
| ANISOU | 1105 | C | PHE | A | 180 | 3912 | 2871 | 4556 | 812 | −1356 | −31 | C |
| ATOM | 1106 | O | PHE | A | 180 | −5.187 | 99.582 | 30.155 | 1.00 | 31.10 | | O |
| ANISOU | 1106 | O | PHE | A | 180 | 4249 | 3091 | 4476 | 745 | −1371 | 86 | O |
| ATOM | 1107 | CB | PHE | A | 180 | −6.565 | 98.142 | 32.598 | 1.00 | 25.14 | | C |
| ANISOU | 1107 | CB | PHE | A | 180 | 3056 | 2476 | 4022 | 771 | −1080 | −285 | C |
| ATOM | 1108 | CG | PHE | A | 180 | −6.087 | 97.262 | 33.710 | 1.00 | 23.47 | | C |
| ANISOU | 1108 | CG | PHE | A | 180 | 2793 | 2385 | 3738 | 702 | −836 | −369 | C |
| ATOM | 1109 | CD1 | PHE | A | 180 | −6.497 | 97.487 | 35.015 | 1.00 | 25.73 | | C |
| ANISOU | 1109 | CD1 | PHE | A | 180 | 2925 | 2676 | 4173 | 717 | −698 | −504 | C |
| ATOM | 1110 | CD2 | PHE | A | 180 | −5.193 | 96.225 | 33.461 | 1.00 | 29.26 | | C |
| ANISOU | 1110 | CD2 | PHE | A | 180 | 3643 | 3223 | 4252 | 620 | −744 | −311 | C |
| ATOM | 1111 | CE1 | PHE | A | 180 | −6.047 | 96.692 | 36.062 | 1.00 | 22.20 | | C |
| ANISOU | 1111 | CE1 | PHE | A | 180 | 2456 | 2342 | 3636 | 643 | −488 | −560 | C |
| ATOM | 1112 | CE2 | PHE | A | 180 | −4.729 | 95.420 | 34.511 | 1.00 | 26.45 | | C |
| ANISOU | 1112 | CE2 | PHE | A | 180 | 3247 | 2962 | 3840 | 559 | −543 | −369 | C |
| ATOM | 1113 | CZ | PHE | A | 180 | −5.156 | 95.655 | 35.805 | 1.00 | 23.95 | | C |
| ANISOU | 1113 | CZ | PHE | A | 180 | 2795 | 2655 | 3650 | 566 | −424 | −481 | C |
| ATOM | 1114 | N | LEU | A | 181 | −6.783 | 100.988 | 30.859 | 1.00 | 28.95 | | N |
| ANISOU | 1114 | N | LEU | A | 181 | 3724 | 2608 | 4666 | 910 | −1546 | −30 | N |
| ATOM | 1115 | CA | LEU | A | 181 | −6.911 | 101.638 | 29.553 | 1.00 | 38.76 | | C |
| ANISOU | 1115 | CA | LEU | A | 181 | 5118 | 3745 | 5866 | 935 | −1805 | 141 | C |
| ATOM | 1116 | C | LEU | A | 181 | −5.815 | 102.676 | 29.298 | 1.00 | 38.02 | | C |
| ANISOU | 1116 | C | LEU | A | 181 | 5211 | 3559 | 5675 | 893 | −1790 | 295 | C |
| ATOM | 1117 | O | LEU | A | 181 | −5.804 | 103.321 | 28.254 | 1.00 | 40.57 | | O |
| ANISOU | 1117 | O | LEU | A | 181 | 5688 | 3783 | 5944 | 898 | −1990 | 465 | O |
| ATOM | 1118 | CB | LEU | A | 181 | −8.289 | 102.301 | 29.404 | 1.00 | 36.62 | | C |
| ANISOU | 1118 | CB | LEU | A | 181 | 4688 | 3324 | 5901 | 1064 | −2047 | 99 | C |
| ATOM | 1119 | CG | LEU | A | 181 | −9.523 | 101.379 | 29.424 | 1.00 | 36.92 | | C |
| ANISOU | 1119 | CG | LEU | A | 181 | 4528 | 3429 | 6072 | 1105 | −2118 | −35 | C |
| ATOM | 1120 | CD1 | LEU | A | 181 | −10.791 | 102.161 | 29.155 | 1.00 | 36.71 | | C |
| ANISOU | 1120 | CD1 | LEU | A | 181 | 4358 | 3276 | 6316 | 1185 | −2315 | −68 | C |
| ATOM | 1121 | CD2 | LEU | A | 181 | −9.379 | 100.256 | 28.423 | 1.00 | 34.20 | | C |
| ANISOU | 1121 | CD2 | LEU | A | 181 | 4323 | 3215 | 5457 | 1025 | −2184 | 35 | C |
| ATOM | 1122 | N | TYR | A | 182 | −4.900 | 102.845 | 30.244 | 1.00 | 29.50 | | N |
| ANISOU | 1122 | N | TYR | A | 182 | 4123 | 2509 | 4576 | 844 | −1565 | 244 | N |
| ATOM | 1123 | CA | TYR | A | 182 | −3.825 | 103.813 | 30.088 | 1.00 | 29.75 | | C |
| ANISOU | 1123 | CA | TYR | A | 182 | 4310 | 2452 | 4543 | 791 | −1535 | 375 | C |
| ATOM | 1124 | C | TYR | A | 182 | −2.535 | 103.238 | 30.605 | 1.00 | 35.33 | | C |
| ANISOU | 1124 | C | TYR | A | 182 | 5067 | 3296 | 5060 | 682 | −1283 | 359 | C |
| ATOM | 1125 | O | TYR | A | 182 | −1.840 | 103.851 | 31.404 | 1.00 | 46.60 | | O |
| ANISOU | 1125 | O | TYR | A | 182 | 6477 | 4680 | 6548 | 655 | −1166 | 326 | O |
| ATOM | 1126 | CB | TYR | A | 182 | −4.155 | 105.109 | 30.831 | 1.00 | 35.29 | | C |
| ANISOU | 1126 | CB | TYR | A | 182 | 4910 | 2964 | 5535 | 871 | −1579 | 313 | C |
| ATOM | 1127 | CG | TYR | A | 182 | −5.431 | 105.767 | 30.375 | 1.00 | 36.81 | | C |
| ANISOU | 1127 | CG | TYR | A | 182 | 5023 | 2990 | 5972 | 997 | −1841 | 323 | C |
| ATOM | 1128 | CD1 | TYR | A | 182 | −6.655 | 105.415 | 30.935 | 1.00 | 40.17 | | C |
| ANISOU | 1128 | CD1 | TYR | A | 182 | 5218 | 3427 | 6619 | 1096 | −1867 | 140 | C |
| ATOM | 1129 | CD2 | TYR | A | 182 | −5.414 | 106.762 | 29.401 | 1.00 | 35.35 | | C |
| ANISOU | 1129 | CD2 | TYR | A | 182 | 4975 | 2674 | 5783 | 986 | −2019 | 503 | C |
| ATOM | 1130 | CE1 | TYR | A | 182 | −7.831 | 106.030 | 30.526 | 1.00 | 38.44 | | C |
| ANISOU | 1130 | CE1 | TYR | A | 182 | 4894 | 3120 | 6593 | 1160 | −2042 | 124 | C |
| ATOM | 1131 | CE2 | TYR | A | 182 | −6.581 | 107.385 | 28.992 | 1.00 | 37.76 | | C |
| ANISOU | 1131 | CE2 | TYR | A | 182 | 5185 | 2891 | 6271 | 1054 | −2199 | 490 | C |
| ATOM | 1132 | CZ | TYR | A | 182 | −7.785 | 107.016 | 29.559 | 1.00 | 40.10 | | C |
| ANISOU | 1132 | CZ | TYR | A | 182 | 5243 | 3212 | 6783 | 1143 | −2215 | 299 | C |
| ATOM | 1133 | OH | TYR | A | 182 | −8.953 | 107.629 | 29.158 | 1.00 | 51.58 | | O |
| ANISOU | 1133 | OH | TYR | A | 182 | 6592 | 4569 | 8436 | 1207 | −2398 | 283 | O |
| ATOM | 1134 | N | GLN | A | 183 | −2.214 | 102.045 | 30.137 | 1.00 | 37.30 | | N |
| ANISOU | 1134 | N | GLN | A | 183 | 5377 | 3706 | 5091 | 621 | −1212 | 375 | N |
| ATOM | 1135 | CA | GLN | A | 183 | −1.119 | 101.299 | 30.703 | 1.00 | 32.82 | | C |
| ANISOU | 1135 | CA | GLN | A | 183 | 4816 | 3273 | 4380 | 537 | −982 | 336 | C |
| ATOM | 1136 | C | GLN | A | 183 | −0.278 | 100.650 | 29.621 | 1.00 | 32.35 | | C |
| ANISOU | 1136 | C | GLN | A | 183 | 4927 | 3310 | 4053 | 450 | −941 | 453 | C |
| ATOM | 1137 | O | GLN | A | 183 | −0.790 | 99.947 | 28.759 | 1.00 | 46.53 | | O |
| ANISOU | 1137 | O | GLN | A | 183 | 6776 | 5161 | 5741 | 455 | −1030 | 471 | O |
| ATOM | 1138 | CB | GLN | A | 183 | −1.699 | 100.286 | 31.679 | 1.00 | 28.58 | | C |
| ANISOU | 1138 | CB | GLN | A | 183 | 4109 | 2841 | 3911 | 564 | −883 | 164 | C |
| ATOM | 1139 | CG | GLN | A | 183 | −0.953 | 99.036 | 31.896 | 1.00 | 23.18 | | C |
| ANISOU | 1139 | CG | GLN | A | 183 | 3437 | 2309 | 3060 | 494 | −715 | 135 | C |
| ATOM | 1140 | CD | GLN | A | 183 | −1.824 | 98.035 | 32.609 | 1.00 | 29.19 | | C |
| ANISOU | 1140 | CD | GLN | A | 183 | 4048 | 3146 | 3897 | 523 | −670 | −4 | C |
| ATOM | 1141 | OE1 | GLN | A | 183 | −2.447 | 98.356 | 33.622 | 1.00 | 34.53 | | O |
| ANISOU | 1141 | OE1 | GLN | A | 183 | 4587 | 3794 | 4739 | 564 | −639 | −114 | O |
| ATOM | 1142 | NE2 | GLN | A | 183 | −1.880 | 96.818 | 32.091 | 1.00 | 21.84 | | N |
| ANISOU | 1142 | NE2 | GLN | A | 183 | 3143 | 2308 | 2848 | 493 | −655 | −8 | N |
| ATOM | 1143 | N | GLN | A | 184 | 1.019 | 100.908 | 29.665 | 1.00 | 26.52 | | N |
| ANISOU | 1143 | N | GLN | A | 184 | 4269 | 2591 | 3218 | 367 | −802 | 522 | N |
| ATOM | 1144 | CA | GLN | A | 184 | 1.940 | 100.370 | 28.680 | 1.00 | 27.98 | | C |
| ANISOU | 1144 | CA | GLN | A | 184 | 4604 | 2867 | 3161 | 277 | −721 | 619 | C |
| ATOM | 1145 | C | GLN | A | 184 | 2.094 | 98.857 | 28.824 | 1.00 | 30.61 | | C |
| ANISOU | 1145 | C | GLN | A | 184 | 4884 | 3355 | 3392 | 265 | −599 | 514 | C |
| ATOM | 1146 | O | GLN | A | 184 | 2.070 | 98.126 | 27.821 | 1.00 | 27.65 | | O |
| ANISOU | 1146 | O | GLN | A | 184 | 4611 | 3052 | 2842 | 238 | −615 | 539 | O |
| ATOM | 1147 | CB | GLN | A | 184 | 3.298 | 101.058 | 28.798 | 1.00 | 34.38 | | C |
| ANISOU | 1147 | CB | GLN | A | 184 | 5472 | 3652 | 3940 | 189 | −588 | 704 | C |
| ATOM | 1148 | CG | GLN | A | 184 | 3.441 | 102.316 | 27.940 | 1.00 | 45.98 | | C |
| ANISOU | 1148 | CG | GLN | A | 184 | 7095 | 4987 | 5389 | 149 | −696 | 882 | C |
| ATOM | 1149 | CD | GLN | A | 184 | 3.540 | 102.006 | 26.440 | 1.00 | 58.54 | | C |
| ANISOU | 1149 | CD | GLN | A | 184 | 8884 | 6634 | 6723 | 89 | −736 | 1014 | C |
| ATOM | 1150 | OE1 | GLN | A | 184 | 4.605 | 101.621 | 25.945 | 1.00 | 60.98 | | O |
| ANISOU | 1150 | OE1 | GLN | A | 184 | 9278 | 7038 | 6855 | −10 | −569 | 1060 | O |
| ATOM | 1151 | NE2 | GLN | A | 184 | 2.428 | 102.169 | 25.716 | 1.00 | 58.08 | | N |
| ANISOU | 1151 | NE2 | GLN | A | 184 | 8899 | 6520 | 6647 | 146 | −959 | 1067 | N |
| ATOM | 1152 | N | ALA | A | 185 | 2.248 | 98.383 | 30.062 | 1.00 | 28.25 | | N |
| ANISOU | 1152 | N | ALA | A | 185 | 4436 | 3100 | 3198 | 281 | −484 | 396 | N |
| ATOM | 1153 | CA | ALA | A | 185 | 2.459 | 96.951 | 30.281 | 1.00 | 29.81 | | C |
| ANISOU | 1153 | CA | ALA | A | 185 | 4583 | 3420 | 3323 | 267 | −371 | 310 | C |
| ATOM | 1154 | C | ALA | A | 185 | 1.231 | 96.177 | 29.784 | 1.00 | 31.23 | | C |
| ANISOU | 1154 | C | ALA | A | 185 | 4748 | 3624 | 3496 | 314 | −489 | 252 | C |
| ATOM | 1155 | O | ALA | A | 185 | 0.088 | 96.649 | 29.892 | 1.00 | 33.68 | | O |
| ANISOU | 1155 | O | ALA | A | 185 | 4997 | 3864 | 3935 | 376 | −633 | 227 | O |
| ATOM | 1156 | CB | ALA | A | 185 | 2.742 | 96.656 | 31.733 | 1.00 | 18.91 | | C |
| ANISOU | 1156 | CB | ALA | A | 185 | 3062 | 2071 | 2052 | 273 | −257 | 216 | C |
| ATOM | 1157 | N | THR | A | 186 | 1.469 | 95.004 | 29.216 | 1.00 | 31.52 | | N |
| ANISOU | 1157 | N | THR | A | 186 | 4829 | 3747 | 3400 | 285 | −434 | 223 | N |
| ATOM | 1158 | CA | THR | A | 186 | 0.400 | 94.255 | 28.554 | 1.00 | 32.83 | | C |
| ANISOU | 1158 | CA | THR | A | 186 | 5003 | 3932 | 3539 | 311 | −560 | 171 | C |
| ATOM | 1159 | C | THR | A | 186 | −0.495 | 93.521 | 29.538 | 1.00 | 26.74 | | C |
| ANISOU | 1159 | C | THR | A | 186 | 4057 | 3171 | 2931 | 350 | −556 | 49 | C |
| ATOM | 1160 | O | THR | A | 186 | −1.711 | 93.500 | 29.359 | 1.00 | 24.70 | | O |
| ANISOU | 1160 | O | THR | A | 186 | 3740 | 2880 | 2764 | 391 | −702 | 7 | O |
| ATOM | 1161 | CB | THR | A | 186 | 0.974 | 93.258 | 27.561 | 1.00 | 36.19 | | C |
| ANISOU | 1161 | CB | THR | A | 186 | 5549 | 4438 | 3763 | 260 | −497 | 162 | C |
| ATOM | 1162 | OG1 | THR | A | 186 | 1.688 | 93.977 | 26.553 | 1.00 | 33.90 | | O |
| ANISOU | 1162 | OG1 | THR | A | 186 | 5433 | 4147 | 3301 | 211 | −496 | 279 | O |
| ATOM | 1163 | CG2 | THR | A | 186 | −0.132 | 92.424 | 26.915 | 1.00 | 28.58 | | C |
| ANISOU | 1163 | CG2 | THR | A | 186 | 4591 | 3490 | 2776 | 279 | −638 | 88 | C |
| ATOM | 1164 | N | GLY | A | 187 | 0.097 | 92.963 | 30.594 | 1.00 | 21.15 | | N |
| ANISOU | 1164 | N | GLY | A | 187 | 3264 | 2504 | 2267 | 332 | −395 | 1 | N |
| ATOM | 1165 | CA | GLY | A | 187 | −0.673 | 92.257 | 31.605 | 1.00 | 18.33 | | C |
| ANISOU | 1165 | CA | GLY | A | 187 | 2757 | 2161 | 2044 | 348 | −365 | −97 | C |
| ATOM | 1166 | C | GLY | A | 187 | −0.114 | 92.351 | 33.009 | 1.00 | 24.81 | | C |
| ANISOU | 1166 | C | GLY | A | 187 | 3495 | 2999 | 2931 | 334 | −227 | −116 | C |
| ATOM | 1167 | O | GLY | A | 187 | 0.723 | 93.210 | 33.294 | 1.00 | 22.07 | | O |
| ANISOU | 1167 | O | GLY | A | 187 | 3183 | 2636 | 2567 | 324 | −184 | −66 | O |
| ATOM | 1168 | N | VAL | A | 188 | −0.567 | 91.449 | 33.880 | 1.00 | 24.28 | | N |
| ANISOU | 1168 | N | VAL | A | 188 | 3328 | 2966 | 2933 | 322 | −164 | −186 | N |
| ATOM | 1169 | CA | VAL | A | 188 | −0.205 | 91.459 | 35.296 | 1.00 | 28.92 | | C |
| ANISOU | 1169 | CA | VAL | A | 188 | 3845 | 3580 | 3562 | 300 | −49 | −206 | C |
| ATOM | 1170 | C | VAL | A | 188 | 0.322 | 90.092 | 35.764 | 1.00 | 28.44 | | C |
| ANISOU | 1170 | C | VAL | A | 188 | 3776 | 3567 | 3461 | 257 | 47 | −205 | C |
| ATOM | 1171 | O | VAL | A | 188 | −0.290 | 89.065 | 35.508 | 1.00 | 31.25 | | O |
| ANISOU | 1171 | O | VAL | A | 188 | 4106 | 3927 | 3841 | 247 | 35 | −240 | O |
| ATOM | 1172 | CB | VAL | A | 188 | −1.419 | 91.860 | 36.175 | 1.00 | 24.63 | | C |
| ANISOU | 1172 | CB | VAL | A | 188 | 3179 | 3023 | 3157 | 320 | −55 | −289 | C |
| ATOM | 1173 | CG1 | VAL | A | 188 | −1.080 | 91.756 | 37.641 | 1.00 | 16.06 | | C |
| ANISOU | 1173 | CG1 | VAL | A | 188 | 2047 | 1983 | 2072 | 281 | 72 | −316 | C |
| ATOM | 1174 | CG2 | VAL | A | 188 | −1.904 | 93.288 | 35.835 | 1.00 | 17.35 | | C |
| ANISOU | 1174 | CG2 | VAL | A | 188 | 2248 | 2027 | 2317 | 377 | −158 | −296 | C |
| ATOM | 1175 | N | LEU | A | 189 | 1.458 | 90.086 | 36.452 | 1.00 | 24.31 | | N |
| ANISOU | 1175 | N | LEU | A | 189 | 3273 | 3071 | 2894 | 232 | 129 | −164 | N |
| ATOM | 1176 | CA | LEU | A | 189 | 2.027 | 88.852 | 36.970 | 1.00 | 14.97 | | C |
| ANISOU | 1176 | CA | LEU | A | 189 | 2080 | 1915 | 1693 | 200 | 199 | −147 | C |
| ATOM | 1177 | C | LEU | A | 189 | 1.933 | 88.832 | 38.474 | 1.00 | 20.91 | | C |
| ANISOU | 1177 | C | LEU | A | 189 | 2779 | 2698 | 2467 | 166 | 256 | −153 | C |
| ATOM | 1178 | O | LEU | A | 189 | 2.755 | 89.422 | 39.162 | 1.00 | 21.51 | | O |
| ANISOU | 1178 | O | LEU | A | 189 | 2868 | 2793 | 2511 | 153 | 280 | −126 | O |
| ATOM | 1179 | CB | LEU | A | 189 | 3.482 | 88.684 | 36.517 | 1.00 | 15.63 | | C |
| ANISOU | 1179 | CB | LEU | A | 189 | 2220 | 2002 | 1715 | 198 | 235 | −92 | C |
| ATOM | 1180 | CG | LEU | A | 189 | 4.307 | 87.456 | 36.954 | 1.00 | 27.62 | | C |
| ANISOU | 1180 | CG | LEU | A | 189 | 3724 | 3527 | 3243 | 182 | 291 | −66 | C |
| ATOM | 1181 | CD1 | LEU | A | 189 | 3.592 | 86.151 | 36.617 | 1.00 | 18.14 | | C |
| ANISOU | 1181 | CD1 | LEU | A | 189 | 2513 | 2300 | 2077 | 180 | 285 | −102 | C |
| ATOM | 1182 | CD2 | LEU | A | 189 | 5.685 | 87.456 | 36.276 | 1.00 | 19.03 | | C |
| ANISOU | 1182 | CD2 | LEU | A | 189 | 2667 | 2438 | 2125 | 192 | 330 | −33 | C |
| ATOM | 1183 | N | GLY | A | 190 | 0.913 | 88.153 | 38.981 | 1.00 | 18.88 | | N |
| ANISOU | 1183 | N | GLY | A | 190 | 2465 | 2450 | 2258 | 142 | 278 | −191 | N |
| ATOM | 1184 | CA | GLY | A | 190 | 0.748 | 87.972 | 40.411 | 1.00 | 15.05 | | C |
| ANISOU | 1184 | CA | GLY | A | 190 | 1948 | 2007 | 1764 | 91 | 351 | −192 | C |
| ATOM | 1185 | C | GLY | A | 190 | 1.789 | 87.024 | 40.994 | 1.00 | 26.18 | | C |
| ANISOU | 1185 | C | GLY | A | 190 | 3399 | 3429 | 3121 | 55 | 379 | −109 | C |
| ATOM | 1186 | O | GLY | A | 190 | 2.088 | 85.988 | 40.391 | 1.00 | 28.39 | | O |
| ANISOU | 1186 | O | GLY | A | 190 | 3694 | 3671 | 3422 | 61 | 365 | −76 | O |
| ATOM | 1187 | N | MET | A | 191 | 2.342 | 87.377 | 42.157 | 1.00 | 24.41 | | N |
| ANISOU | 1187 | N | MET | A | 191 | 3193 | 3248 | 2833 | 19 | 407 | −80 | N |
| ATOM | 1188 | CA | MET | A | 191 | 3.430 | 86.612 | 42.743 | 1.00 | 24.84 | | C |
| ANISOU | 1188 | CA | MET | A | 191 | 3285 | 3307 | 2845 | −7 | 398 | 11 | C |
| ATOM | 1189 | C | MET | A | 191 | 3.068 | 85.927 | 44.058 | 1.00 | 28.58 | | C |
| ANISOU | 1189 | C | MET | A | 191 | 3775 | 3819 | 3265 | −84 | 441 | 55 | C |
| ATOM | 1190 | O | MET | A | 191 | 3.942 | 85.399 | 44.754 | 1.00 | 26.83 | | O |
| ANISOU | 1190 | O | MET | A | 191 | 3594 | 3604 | 2997 | −111 | 411 | 145 | O |
| ATOM | 1191 | CB | MET | A | 191 | 4.634 | 87.531 | 42.952 | 1.00 | 24.45 | | C |
| ANISOU | 1191 | CB | MET | A | 191 | 3258 | 3276 | 2755 | 6 | 363 | 31 | C |
| ATOM | 1192 | CG | MET | A | 191 | 5.195 | 88.081 | 41.642 | 1.00 | 21.36 | | C |
| ANISOU | 1192 | CG | MET | A | 191 | 2865 | 2846 | 2407 | 63 | 336 | 18 | C |
| ATOM | 1193 | SD | MET | A | 191 | 5.895 | 86.803 | 40.566 | 1.00 | 26.99 | | S |
| ANISOU | 1193 | SD | MET | A | 191 | 3576 | 3507 | 3171 | 99 | 333 | 61 | S |
| ATOM | 1194 | CE | MET | A | 191 | 7.422 | 86.491 | 41.417 | 1.00 | 14.41 | | C |
| ANISOU | 1194 | CE | MET | A | 191 | 1969 | 1922 | 1586 | 86 | 306 | 143 | C |
| ATOM | 1195 | N | SER | A | 192 | 1.787 | 85.888 | 44.397 | 1.00 | 22.62 | | N |
| ANISOU | 1195 | N | SER | A | 192 | 2987 | 3088 | 2521 | −123 | 508 | −1 | N |
| ATOM | 1196 | CA | SER | A | 192 | 1.434 | 85.285 | 45.679 | 1.00 | 25.05 | | C |
| ANISOU | 1196 | CA | SER | A | 192 | 3323 | 3441 | 2752 | −216 | 573 | 47 | C |
| ATOM | 1197 | C | SER | A | 192 | 1.279 | 83.755 | 45.550 | 1.00 | 24.93 | | C |
| ANISOU | 1197 | C | SER | A | 192 | 3315 | 3364 | 2791 | −252 | 571 | 137 | C |
| ATOM | 1198 | O | SER | A | 192 | 1.443 | 83.200 | 44.472 | 1.00 | 23.69 | | O |
| ANISOU | 1198 | O | SER | A | 192 | 3136 | 3132 | 2734 | −198 | 522 | 138 | O |
| ATOM | 1199 | CB | SER | A | 192 | 0.166 | 85.933 | 46.243 | 1.00 | 28.48 | | C |
| ANISOU | 1199 | CB | SER | A | 192 | 3708 | 3935 | 3177 | −257 | 677 | −61 | C |
| ATOM | 1200 | OG | SER | A | 192 | −0.949 | 85.655 | 45.426 | 1.00 | 36.66 | | O |
| ANISOU | 1200 | OG | SER | A | 192 | 4653 | 4929 | 4346 | −238 | 699 | −125 | O |
| ATOM | 1201 | N | LEU | A | 193 | 0.955 | 83.089 | 46.646 | 1.00 | 21.78 | | N |
| ANISOU | 1201 | N | LEU | A | 193 | 2956 | 2994 | 2324 | −349 | 628 | 209 | N |
| ATOM | 1202 | CA | LEU | A | 193 | 1.116 | 81.640 | 46.706 | 1.00 | 31.68 | | C |
| ANISOU | 1202 | CA | LEU | A | 193 | 4243 | 4170 | 3626 | −389 | 602 | 331 | C |
| ATOM | 1203 | C | LEU | A | 193 | −0.179 | 80.889 | 46.441 | 1.00 | 32.42 | | C |
| ANISOU | 1203 | C | LEU | A | 193 | 4276 | 4222 | 3821 | −446 | 678 | 300 | C |
| ATOM | 1204 | O | LEU | A | 193 | −1.282 | 81.420 | 46.612 | 1.00 | 32.49 | | O |
| ANISOU | 1204 | O | LEU | A | 193 | 4219 | 4289 | 3835 | −483 | 774 | 204 | O |
| ATOM | 1205 | CB | LEU | A | 193 | 1.685 | 81.227 | 48.073 | 1.00 | 20.61 | | C |
| ANISOU | 1205 | CB | LEU | A | 193 | 2945 | 2804 | 2083 | −473 | 591 | 471 | C |
| ATOM | 1206 | CG | LEU | A | 193 | 2.934 | 82.003 | 48.504 | 1.00 | 24.56 | | C |
| ANISOU | 1206 | CG | LEU | A | 193 | 3497 | 3354 | 2480 | −434 | 501 | 496 | C |
| ATOM | 1207 | CD1 | LEU | A | 193 | 3.247 | 81.748 | 49.977 | 1.00 | 23.27 | | C |
| ANISOU | 1207 | CD1 | LEU | A | 193 | 3449 | 3254 | 2139 | −537 | 486 | 619 | C |
| ATOM | 1208 | CD2 | LEU | A | 193 | 4.139 | 81.661 | 47.637 | 1.00 | 19.55 | | C |
| ANISOU | 1208 | CD2 | LEU | A | 193 | 2838 | 2628 | 1961 | −333 | 381 | 538 | C |
| ATOM | 1209 | N | SER | A | 194 | −0.016 | 79.630 | 46.060 | 1.00 | 34.77 | | N |
| ANISOU | 1209 | N | SER | A | 194 | 4585 | 4409 | 4216 | −454 | 634 | 379 | N |
| ATOM | 1210 | CA | SER | A | 194 | −1.122 | 78.738 | 45.722 | 1.00 | 30.70 | | C |
| ANISOU | 1210 | CA | SER | A | 194 | 4012 | 3826 | 3827 | −515 | 684 | 358 | C |
| ATOM | 1211 | C | SER | A | 194 | −1.877 | 78.298 | 46.960 | 1.00 | 35.97 | | C |
| ANISOU | 1211 | C | SER | A | 194 | 4704 | 4534 | 4430 | −661 | 799 | 438 | C |
| ATOM | 1212 | O | SER | A | 194 | −1.275 | 78.022 | 47.989 | 1.00 | 45.32 | | O |
| ANISOU | 1212 | O | SER | A | 194 | 5993 | 5739 | 5488 | −720 | 795 | 574 | O |
| ATOM | 1213 | CB | SER | A | 194 | −0.598 | 77.510 | 44.964 | 1.00 | 23.87 | | C |
| ANISOU | 1213 | CB | SER | A | 194 | 3164 | 2812 | 3093 | −479 | 596 | 411 | C |
| ATOM | 1214 | OG | SER | A | 194 | 0.274 | 77.888 | 43.897 | 1.00 | 25.33 | | O |
| ANISOU | 1214 | OG | SER | A | 194 | 3343 | 2973 | 3307 | −352 | 511 | 344 | O |
| ATOM | 1215 | N | LYS | A | 195 | −3.201 | 78.272 | 46.876 | 1.00 | 40.47 | | N |
| ANISOU | 1215 | N | LYS | A | 195 | 5175 | 5120 | 5081 | −726 | 901 | 353 | N |
| ATOM | 1216 | CA | LYS | A | 195 | −4.010 | 77.715 | 47.954 | 1.00 | 44.66 | | C |
| ANISOU | 1216 | CA | LYS | A | 195 | 5717 | 5680 | 5571 | −886 | 1039 | 427 | C |
| ATOM | 1217 | C | LYS | A | 195 | −4.239 | 76.242 | 47.665 | 1.00 | 43.95 | | C |
| ANISOU | 1217 | C | LYS | A | 195 | 5630 | 5441 | 5629 | −952 | 1012 | 522 | C |
| ATOM | 1218 | O | LYS | A | 195 | −4.195 | 75.833 | 46.508 | 1.00 | 39.72 | | O |
| ANISOU | 1218 | O | LYS | A | 195 | 5041 | 4799 | 5251 | −875 | 914 | 459 | O |
| ATOM | 1219 | CB | LYS | A | 195 | −5.350 | 78.443 | 48.110 | 1.00 | 38.60 | | C |
| ANISOU | 1219 | CB | LYS | A | 195 | 4816 | 5008 | 4842 | −933 | 1187 | 277 | C |
| ATOM | 1220 | CG | LYS | A | 195 | −5.261 | 79.866 | 48.603 | 1.00 | 34.93 | | C |
| ANISOU | 1220 | CG | LYS | A | 195 | 4349 | 4679 | 4242 | −888 | 1242 | 177 | C |
| ATOM | 1221 | CD | LYS | A | 195 | −6.623 | 80.511 | 48.486 | 1.00 | 45.87 | | C |
| ANISOU | 1221 | CD | LYS | A | 195 | 5564 | 6120 | 5745 | −903 | 1365 | 4 | C |
| ATOM | 1222 | CE | LYS | A | 195 | −6.613 | 81.951 | 48.947 | 1.00 | 56.00 | | C |
| ANISOU | 1222 | CE | LYS | A | 195 | 6833 | 7516 | 6929 | −850 | 1424 | −120 | C |
| ATOM | 1223 | NZ | LYS | A | 195 | −5.773 | 82.809 | 48.043 | 1.00 | 65.60 | | N |
| ANISOU | 1223 | NZ | LYS | A | 195 | 8068 | 8699 | 8159 | −690 | 1256 | −168 | N |
| ATOM | 1224 | N | PRO | A | 196 | −4.487 | 75.440 | 48.716 | 1.00 | 45.65 | | N |
| ANISOU | 1224 | N | PRO | A | 196 | 5917 | 5643 | 5785 | −1103 | 1098 | 672 | N |
| ATOM | 1225 | CA | PRO | A | 196 | −4.611 | 73.982 | 48.585 | 1.00 | 48.97 | | C |
| ANISOU | 1225 | CA | PRO | A | 196 | 6362 | 5896 | 6349 | −1180 | 1065 | 794 | C |
| ATOM | 1226 | C | PRO | A | 196 | −5.497 | 73.474 | 47.442 | 1.00 | 54.76 | | C |
| ANISOU | 1226 | C | PRO | A | 196 | 6953 | 6523 | 7331 | −1172 | 1050 | 666 | C |
| ATOM | 1227 | O | PRO | A | 196 | −5.037 | 72.600 | 46.708 | 1.00 | 64.77 | | O |
| ANISOU | 1227 | O | PRO | A | 196 | 8242 | 7633 | 8735 | −1122 | 930 | 690 | O |
| ATOM | 1228 | CB | PRO | A | 196 | −5.201 | 73.584 | 49.939 | 1.00 | 44.10 | | C |
| ANISOU | 1228 | CB | PRO | A | 196 | 5812 | 5333 | 5612 | −1376 | 1222 | 934 | C |
| ATOM | 1229 | CG | PRO | A | 196 | −4.531 | 74.526 | 50.876 | 1.00 | 43.06 | | C |
| ANISOU | 1229 | CG | PRO | A | 196 | 5790 | 5358 | 5215 | −1362 | 1240 | 970 | C |
| ATOM | 1230 | CD | PRO | A | 196 | −4.455 | 75.851 | 50.130 | 1.00 | 39.63 | | C |
| ANISOU | 1230 | CD | PRO | A | 196 | 5253 | 5014 | 4790 | −1209 | 1211 | 758 | C |
| ATOM | 1231 | N | GLN | A | 197 | −6.710 | 73.980 | 47.269 | 1.00 | 49.42 | | N |
| ANISOU | 1231 | N | GLN | A | 197 | 6130 | 5922 | 6725 | −1216 | 1157 | 522 | N |
| ATOM | 1232 | CA | GLN | A | 197 | −7.504 | 73.549 | 46.113 | 1.00 | 55.06 | | C |
| ANISOU | 1232 | CA | GLN | A | 197 | 6707 | 6538 | 7676 | −1200 | 1104 | 391 | C |
| ATOM | 1233 | C | GLN | A | 197 | −7.650 | 74.678 | 45.098 | 1.00 | 54.30 | | C |
| ANISOU | 1233 | C | GLN | A | 197 | 6513 | 6514 | 7605 | −1052 | 1028 | 198 | C |
| ATOM | 1234 | O | GLN | A | 197 | −8.649 | 74.769 | 44.389 | 1.00 | 53.56 | | O |
| ANISOU | 1234 | O | GLN | A | 197 | 6271 | 6408 | 7670 | −1055 | 1016 | 60 | O |
| ATOM | 1235 | CB | GLN | A | 197 | −8.872 | 73.011 | 46.540 | 1.00 | 63.74 | | C |
| ANISOU | 1235 | CB | GLN | A | 197 | 7686 | 7625 | 8906 | −1375 | 1252 | 383 | C |
| ATOM | 1236 | CG | GLN | A | 197 | −8.797 | 71.692 | 47.309 | 1.00 | 64.33 | | C |
| ANISOU | 1236 | CG | GLN | A | 197 | 7861 | 7581 | 9000 | −1535 | 1304 | 587 | C |
| ATOM | 1237 | CD | GLN | A | 197 | −8.887 | 71.875 | 48.810 | 1.00 | 73.86 | | C |
| ANISOU | 1237 | CD | GLN | A | 197 | 9156 | 8908 | 10000 | −1675 | 1484 | 729 | C |
| ATOM | 1238 | OE1 | GLN | A | 197 | −9.604 | 72.750 | 49.303 | 1.00 | 75.02 | | O |
| ANISOU | 1238 | OE1 | GLN | A | 197 | 9215 | 9215 | 10075 | −1717 | 1641 | 633 | O |
| ATOM | 1239 | NE2 | GLN | A | 197 | −8.146 | 71.054 | 49.547 | 1.00 | 78.61 | | N |
| ANISOU | 1239 | NE2 | GLN | A | 197 | 9936 | 9430 | 10502 | −1746 | 1457 | 955 | N |
| ATOM | 1240 | N | GLY | A | 198 | −6.642 | 75.543 | 45.039 | 1.00 | 46.33 | | N |
| ANISOU | 1240 | N | GLY | A | 198 | 5586 | 5573 | 6443 | −929 | 965 | 197 | N |
| ATOM | 1241 | CA | GLY | A | 198 | −6.710 | 76.714 | 44.200 | 1.00 | 38.67 | | C |
| ANISOU | 1241 | CA | GLY | A | 198 | 4549 | 4672 | 5473 | −799 | 899 | 45 | C |
| ATOM | 1242 | C | GLY | A | 198 | −5.852 | 76.570 | 42.961 | 1.00 | 36.22 | | C |
| ANISOU | 1242 | C | GLY | A | 198 | 4294 | 4281 | 5186 | −672 | 736 | 11 | C |
| ATOM | 1243 | O | GLY | A | 198 | −5.167 | 75.570 | 42.769 | 1.00 | 31.63 | | O |
| ANISOU | 1243 | O | GLY | A | 198 | 3792 | 3589 | 4635 | −672 | 680 | 89 | O |
| ATOM | 1244 | N | ILE | A | 199 | −5.899 | 77.582 | 42.107 | 1.00 | 31.50 | | N |
| ANISOU | 1244 | N | ILE | A | 199 | 3655 | 3735 | 4578 | −564 | 665 | −108 | N |
| ATOM | 1245 | CA | ILE | A | 199 | −5.117 | 77.585 | 40.891 | 1.00 | 29.52 | | C |
| ANISOU | 1245 | CA | ILE | A | 199 | 3465 | 3433 | 4319 | −452 | 533 | −150 | C |
| ATOM | 1246 | C | ILE | A | 199 | −3.644 | 77.652 | 41.234 | 1.00 | 29.19 | | C |
| ANISOU | 1246 | C | ILE | A | 199 | 3546 | 3396 | 4149 | −397 | 523 | −48 | C |
| ATOM | 1247 | O | ILE | A | 199 | −3.236 | 78.539 | 41.969 | 1.00 | 32.23 | | O |
| ANISOU | 1247 | O | ILE | A | 199 | 3959 | 3873 | 4415 | −383 | 567 | −10 | O |
| ATOM | 1248 | CB | ILE | A | 199 | −5.500 | 78.797 | 40.020 | 1.00 | 36.83 | | C |
| ANISOU | 1248 | CB | ILE | A | 199 | 4335 | 4423 | 5236 | −362 | 462 | −272 | C |
| ATOM | 1249 | CG1 | ILE | A | 199 | −7.003 | 78.748 | 39.690 | 1.00 | 35.30 | | C |
| ANISOU | 1249 | CG1 | ILE | A | 199 | 3992 | 4221 | 5201 | −409 | 447 | −377 | C |
| ATOM | 1250 | CG2 | ILE | A | 199 | −4.630 | 78.864 | 38.780 | 1.00 | 30.91 | | C |
| ANISOU | 1250 | CG2 | ILE | A | 199 | 3672 | 3638 | 4435 | −261 | 346 | −305 | C |
| ATOM | 1251 | CD1 | ILE | A | 199 | −7.575 | 80.077 | 39.181 | 1.00 | 30.49 | | C |
| ANISOU | 1251 | CD1 | ILE | A | 199 | 3304 | 3677 | 4604 | −329 | 384 | −477 | C |
| ATOM | 1252 | N | PRO | A | 200 | −2.834 | 76.721 | 40.707 | 1.00 | 27.39 | | N |
| ANISOU | 1252 | N | PRO | A | 200 | 3385 | 3063 | 3960 | −365 | 462 | −15 | N |
| ATOM | 1253 | CA | PRO | A | 200 | −1.386 | 76.858 | 40.906 | 1.00 | 30.43 | | C |
| ANISOU | 1253 | CA | PRO | A | 200 | 3857 | 3450 | 4254 | −297 | 440 | 64 | C |
| ATOM | 1254 | C | PRO | A | 200 | −0.835 | 78.151 | 40.296 | 1.00 | 25.33 | | C |
| ANISOU | 1254 | C | PRO | A | 200 | 3222 | 2893 | 3508 | −199 | 409 | −1 | C |
| ATOM | 1255 | O | PRO | A | 200 | −0.989 | 78.403 | 39.107 | 1.00 | 25.90 | | O |
| ANISOU | 1255 | O | PRO | A | 200 | 3286 | 2958 | 3595 | −143 | 357 | −103 | O |
| ATOM | 1256 | CB | PRO | A | 200 | −0.823 | 75.623 | 40.196 | 1.00 | 20.57 | | C |
| ANISOU | 1256 | CB | PRO | A | 200 | 2643 | 2057 | 3114 | −268 | 384 | 61 | C |
| ATOM | 1257 | CG | PRO | A | 200 | −1.889 | 74.651 | 40.307 | 1.00 | 21.82 | | C |
| ANISOU | 1257 | CG | PRO | A | 200 | 2760 | 2131 | 3401 | −366 | 400 | 55 | C |
| ATOM | 1258 | CD | PRO | A | 200 | −3.154 | 75.439 | 40.077 | 1.00 | 23.19 | | C |
| ANISOU | 1258 | CD | PRO | A | 200 | 2843 | 2395 | 3572 | −398 | 421 | −46 | C |
| ATOM | 1259 | N | THR | A | 201 | −0.158 | 78.935 | 41.116 | 1.00 | 18.25 | | N |
| ANISOU | 1259 | N | THR | A | 201 | 2357 | 2075 | 2503 | −188 | 435 | 66 | N |
| ATOM | 1260 | CA | THR | A | 201 | 0.306 | 80.247 | 40.719 | 1.00 | 21.52 | | C |
| ANISOU | 1260 | CA | THR | A | 201 | 2778 | 2567 | 2832 | −116 | 415 | 18 | C |
| ATOM | 1261 | C | THR | A | 201 | 1.687 | 80.176 | 40.159 | 1.00 | 24.51 | | C |
| ANISOU | 1261 | C | THR | A | 201 | 3205 | 2916 | 3193 | −42 | 376 | 41 | C |
| ATOM | 1262 | O | THR | A | 201 | 2.404 | 79.193 | 40.396 | 1.00 | 25.51 | | O |
| ANISOU | 1262 | O | THR | A | 201 | 3354 | 2970 | 3369 | −42 | 365 | 108 | O |
| ATOM | 1263 | CB | THR | A | 201 | 0.328 | 81.203 | 41.900 | 1.00 | 28.04 | | C |
| ANISOU | 1263 | CB | THR | A | 201 | 3606 | 3488 | 3558 | −147 | 464 | 55 | C |
| ATOM | 1264 | OG1 | THR | A | 201 | 1.268 | 80.715 | 42.871 | 1.00 | 30.86 | | O |
| ANISOU | 1264 | OG1 | THR | A | 201 | 4022 | 3839 | 3865 | −176 | 464 | 176 | O |
| ATOM | 1265 | CG2 | THR | A | 201 | −1.066 | 81.298 | 42.524 | 1.00 | 24.32 | | C |
| ANISOU | 1265 | CG2 | THR | A | 201 | 3073 | 3057 | 3112 | −224 | 537 | 15 | C |
| ATOM | 1266 | N | PHE | A | 202 | 2.068 | 81.251 | 39.464 | 1.00 | 20.12 | | N |
| ANISOU | 1266 | N | PHE | A | 202 | 2657 | 2409 | 2577 | 17 | 358 | −11 | N |
| ATOM | 1267 | CA | PHE | A | 202 | 3.354 | 81.353 | 38.784 | 1.00 | 19.07 | | C |
| ANISOU | 1267 | CA | PHE | A | 202 | 2556 | 2263 | 2428 | 81 | 345 | −7 | C |
| ATOM | 1268 | C | PHE | A | 202 | 4.539 | 81.012 | 39.687 | 1.00 | 27.63 | | C |
| ANISOU | 1268 | C | PHE | A | 202 | 3644 | 3333 | 3522 | 83 | 345 | 92 | C |
| ATOM | 1269 | O | PHE | A | 202 | 5.452 | 80.310 | 39.272 | 1.00 | 33.39 | | O |
| ANISOU | 1269 | O | PHE | A | 202 | 4371 | 4000 | 4316 | 125 | 339 | 100 | O |
| ATOM | 1270 | CB | PHE | A | 202 | 3.528 | 82.763 | 38.219 | 1.00 | 19.43 | | C |
| ANISOU | 1270 | CB | PHE | A | 202 | 2615 | 2374 | 2394 | 115 | 337 | −45 | C |
| ATOM | 1271 | CG | PHE | A | 202 | 4.875 | 83.015 | 37.571 | 1.00 | 22.26 | | C |
| ANISOU | 1271 | CG | PHE | A | 202 | 2997 | 2732 | 2731 | 163 | 350 | −37 | C |
| ATOM | 1272 | CD1 | PHE | A | 202 | 5.938 | 83.543 | 38.314 | 1.00 | 18.67 | | C |
| ANISOU | 1272 | CD1 | PHE | A | 202 | 2528 | 2307 | 2261 | 165 | 359 | 28 | C |
| ATOM | 1273 | CD2 | PHE | A | 202 | 5.070 | 82.753 | 36.224 | 1.00 | 18.74 | | C |
| ANISOU | 1273 | CD2 | PHE | A | 202 | 2584 | 2262 | 2274 | 196 | 358 | −102 | C |
| ATOM | 1274 | CE1 | PHE | A | 202 | 7.171 | 83.772 | 37.717 | 1.00 | 15.42 | | C |
| ANISOU | 1274 | CE1 | PHE | A | 202 | 2111 | 1893 | 1854 | 200 | 383 | 30 | C |
| ATOM | 1275 | CE2 | PHE | A | 202 | 6.289 | 82.999 | 35.614 | 1.00 | 22.58 | | C |
| ANISOU | 1275 | CE2 | PHE | A | 202 | 3084 | 2757 | 2740 | 229 | 401 | −103 | C |
| ATOM | 1276 | CZ | PHE | A | 202 | 7.346 | 83.520 | 36.361 | 1.00 | 19.51 | | C |
| ANISOU | 1276 | CZ | PHE | A | 202 | 2657 | 2392 | 2365 | 230 | 418 | −36 | C |
| ATOM | 1277 | N | VAL | A | 203 | 4.520 | 81.498 | 40.920 | 1.00 | 18.76 | | N |
| ANISOU | 1277 | N | VAL | A | 203 | 2523 | 2266 | 2339 | 38 | 347 | 158 | N |
| ATOM | 1278 | CA | VAL | A | 203 | 5.681 | 81.351 | 41.787 | 1.00 | 23.63 | | C |
| ANISOU | 1278 | CA | VAL | A | 203 | 3149 | 2882 | 2948 | 39 | 314 | 256 | C |
| ATOM | 1279 | C | VAL | A | 203 | 5.890 | 79.911 | 42.241 | 1.00 | 29.88 | | C |
| ANISOU | 1279 | C | VAL | A | 203 | 3949 | 3578 | 3824 | 23 | 284 | 343 | C |
| ATOM | 1280 | O | VAL | A | 203 | 7.004 | 79.402 | 42.204 | 1.00 | 27.71 | | O |
| ANISOU | 1280 | O | VAL | A | 203 | 3658 | 3245 | 3625 | 70 | 240 | 390 | O |
| ATOM | 1281 | CB | VAL | A | 203 | 5.575 | 82.269 | 43.017 | 1.00 | 23.56 | | C |
| ANISOU | 1281 | CB | VAL | A | 203 | 3161 | 2964 | 2825 | −15 | 314 | 293 | C |
| ATOM | 1282 | CG1 | VAL | A | 203 | 6.600 | 81.903 | 44.053 | 1.00 | 29.95 | | C |
| ANISOU | 1282 | CG1 | VAL | A | 203 | 3993 | 3770 | 3616 | −32 | 250 | 408 | C |
| ATOM | 1283 | CG2 | VAL | A | 203 | 5.771 | 83.706 | 42.599 | 1.00 | 23.45 | | C |
| ANISOU | 1283 | CG2 | VAL | A | 203 | 3137 | 3012 | 2763 | 15 | 322 | 221 | C |
| ATOM | 1284 | N | ASN | A | 204 | 4.813 | 79.258 | 42.664 | 1.00 | 28.94 | | N |
| ANISOU | 1284 | N | ASN | A | 204 | 3848 | 3436 | 3714 | −45 | 308 | 365 | N |
| ATOM | 1285 | CA | ASN | A | 204 | 4.884 | 77.853 | 43.058 | 1.00 | 32.38 | | C |
| ANISOU | 1285 | CA | ASN | A | 204 | 4302 | 3758 | 4244 | −73 | 278 | 459 | C |
| ATOM | 1286 | C | ASN | A | 204 | 5.254 | 76.970 | 41.868 | 1.00 | 25.22 | | C |
| ANISOU | 1286 | C | ASN | A | 204 | 3367 | 2730 | 3487 | 0 | 263 | 393 | C |
| ATOM | 1287 | O | ASN | A | 204 | 6.091 | 76.091 | 41.991 | 1.00 | 25.40 | | O |
| ANISOU | 1287 | O | ASN | A | 204 | 3385 | 2648 | 3618 | 36 | 212 | 457 | O |
| ATOM | 1288 | CB | ASN | A | 204 | 3.560 | 77.427 | 43.692 | 1.00 | 31.11 | | C |
| ANISOU | 1288 | CB | ASN | A | 204 | 4159 | 3599 | 4061 | −180 | 330 | 490 | C |
| ATOM | 1289 | CG | ASN | A | 204 | 3.318 | 78.138 | 45.011 | 1.00 | 43.11 | | C |
| ANISOU | 1289 | CG | ASN | A | 204 | 5721 | 5236 | 5423 | −260 | 361 | 557 | C |
| ATOM | 1290 | OD1 | ASN | A | 204 | 2.276 | 78.746 | 45.227 | 1.00 | 39.58 | | O |
| ANISOU | 1290 | OD1 | ASN | A | 204 | 5255 | 4871 | 4913 | −314 | 441 | 492 | O |
| ATOM | 1291 | ND2 | ASN | A | 204 | 4.311 | 78.097 | 45.887 | 1.00 | 55.24 | | N |
| ANISOU | 1291 | ND2 | ASN | A | 204 | 7310 | 6783 | 6897 | −264 | 294 | 676 | N |
| ATOM | 1292 | N | LEU | A | 205 | 4.681 | 77.254 | 40.705 | 1.00 | 25.21 | | N |
| ANISOU | 1292 | N | LEU | A | 205 | 3346 | 2742 | 3491 | 26 | 299 | 256 | N |
| ATOM | 1293 | CA | LEU | A | 205 | 5.027 | 76.522 | 39.481 | 1.00 | 25.17 | | C |
| ANISOU | 1293 | CA | LEU | A | 205 | 3329 | 2640 | 3593 | 91 | 298 | 160 | C |
| ATOM | 1294 | C | LEU | A | 205 | 6.486 | 76.699 | 39.074 | 1.00 | 26.66 | | C |
| ANISOU | 1294 | C | LEU | A | 205 | 3495 | 2822 | 3812 | 179 | 296 | 148 | C |
| ATOM | 1295 | O | LEU | A | 205 | 7.147 | 75.731 | 38.668 | 1.00 | 29.31 | | O |
| ANISOU | 1295 | O | LEU | A | 205 | 3810 | 3042 | 4283 | 232 | 289 | 125 | O |
| ATOM | 1296 | CB | LEU | A | 205 | 4.125 | 76.958 | 38.329 | 1.00 | 18.36 | | C |
| ANISOU | 1296 | CB | LEU | A | 205 | 2470 | 1820 | 2685 | 92 | 320 | 20 | C |
| ATOM | 1297 | CG | LEU | A | 205 | 2.706 | 76.389 | 38.400 | 1.00 | 30.80 | | C |
| ANISOU | 1297 | CG | LEU | A | 205 | 4037 | 3357 | 4309 | 15 | 314 | −6 | C |
| ATOM | 1298 | CD1 | LEU | A | 205 | 1.834 | 76.933 | 37.270 | 1.00 | 18.58 | | C |
| ANISOU | 1298 | CD1 | LEU | A | 205 | 2484 | 1858 | 2716 | 21 | 300 | −141 | C |
| ATOM | 1299 | CD2 | LEU | A | 205 | 2.785 | 74.833 | 38.362 | 1.00 | 20.14 | | C |
| ANISOU | 1299 | CD2 | LEU | A | 205 | 2691 | 1844 | 3119 | 2 | 295 | 6 | C |
| ATOM | 1300 | N | LEU | A | 206 | 6.982 | 77.933 | 39.162 | 1.00 | 25.49 | | N |
| ANISOU | 1300 | N | LEU | A | 206 | 3339 | 2787 | 3559 | 194 | 309 | 154 | N |
| ATOM | 1301 | CA | LEU | A | 206 | 8.372 | 78.204 | 38.830 | 1.00 | 21.96 | | C |
| ANISOU | 1301 | CA | LEU | A | 206 | 2851 | 2344 | 3151 | 262 | 319 | 146 | C |
| ATOM | 1302 | C | LEU | A | 206 | 9.269 | 77.326 | 39.676 | 1.00 | 27.14 | | C |
| ANISOU | 1302 | C | LEU | A | 206 | 3467 | 2908 | 3938 | 288 | 255 | 250 | C |
| ATOM | 1303 | O | LEU | A | 206 | 10.165 | 76.672 | 39.148 | 1.00 | 32.79 | | O |
| ANISOU | 1303 | O | LEU | A | 206 | 4129 | 3537 | 4792 | 359 | 265 | 211 | O |
| ATOM | 1304 | CB | LEU | A | 206 | 8.735 | 79.677 | 39.042 | 1.00 | 17.20 | | C |
| ANISOU | 1304 | CB | LEU | A | 206 | 2243 | 1864 | 2429 | 252 | 328 | 161 | C |
| ATOM | 1305 | CG | LEU | A | 206 | 10.190 | 80.106 | 38.815 | 1.00 | 30.69 | | C |
| ANISOU | 1305 | CG | LEU | A | 206 | 3889 | 3587 | 4185 | 303 | 343 | 161 | C |
| ATOM | 1306 | CD1 | LEU | A | 206 | 10.549 | 79.938 | 37.373 | 1.00 | 29.68 | | C |
| ANISOU | 1306 | CD1 | LEU | A | 206 | 3752 | 3439 | 4087 | 351 | 431 | 44 | C |
| ATOM | 1307 | CD2 | LEU | A | 206 | 10.405 | 81.570 | 39.190 | 1.00 | 24.99 | | C |
| ANISOU | 1307 | CD2 | LEU | A | 206 | 3170 | 2971 | 3354 | 271 | 338 | 186 | C |
| ATOM | 1308 | N | PHE | A | 207 | 9.024 | 77.295 | 40.986 | 1.00 | 20.62 | | N |
| ANISOU | 1308 | N | PHE | A | 207 | 2670 | 2097 | 3069 | 229 | 189 | 382 | N |
| ATOM | 1309 | CA | PHE | A | 207 | 9.922 | 76.541 | 41.860 | 1.00 | 28.02 | | C |
| ANISOU | 1309 | CA | PHE | A | 207 | 3583 | 2948 | 4117 | 250 | 94 | 509 | C |
| ATOM | 1310 | C | PHE | A | 207 | 9.718 | 75.024 | 41.740 | 1.00 | 30.68 | | C |
| ANISOU | 1310 | C | PHE | A | 207 | 3924 | 3112 | 4619 | 266 | 66 | 534 | C |
| ATOM | 1311 | O | PHE | A | 207 | 10.685 | 74.280 | 41.828 | 1.00 | 31.43 | | O |
| ANISOU | 1311 | O | PHE | A | 207 | 3967 | 3092 | 4884 | 334 | 2 | 577 | O |
| ATOM | 1312 | CB | PHE | A | 207 | 9.800 | 77.011 | 43.312 | 1.00 | 24.20 | | C |
| ANISOU | 1312 | CB | PHE | A | 207 | 3152 | 2542 | 3500 | 172 | 23 | 648 | C |
| ATOM | 1313 | CG | PHE | A | 207 | 10.431 | 78.361 | 43.536 | 1.00 | 30.99 | | C |
| ANISOU | 1313 | CG | PHE | A | 207 | 3988 | 3532 | 4256 | 174 | 15 | 630 | C |
| ATOM | 1314 | CD1 | PHE | A | 207 | 11.801 | 78.524 | 43.398 | 1.00 | 36.82 | | C |
| ANISOU | 1314 | CD1 | PHE | A | 207 | 4641 | 4253 | 5098 | 243 | −36 | 634 | C |
| ATOM | 1315 | CD2 | PHE | A | 207 | 9.669 | 79.463 | 43.864 | 1.00 | 25.09 | | C |
| ANISOU | 1315 | CD2 | PHE | A | 207 | 3290 | 2910 | 3334 | 109 | 61 | 597 | C |
| ATOM | 1316 | CE1 | PHE | A | 207 | 12.400 | 79.767 | 43.580 | 1.00 | 36.19 | | C |
| ANISOU | 1316 | CE1 | PHE | A | 207 | 4530 | 4278 | 4942 | 234 | −45 | 614 | C |
| ATOM | 1317 | CE2 | PHE | A | 207 | 10.264 | 80.707 | 44.050 | 1.00 | 31.96 | | C |
| ANISOU | 1317 | CE2 | PHE | A | 207 | 4139 | 3875 | 4128 | 108 | 48 | 572 | C |
| ATOM | 1318 | CZ | PHE | A | 207 | 11.631 | 80.858 | 43.904 | 1.00 | 33.59 | | C |
| ANISOU | 1318 | CZ | PHE | A | 207 | 4267 | 4064 | 4434 | 165 | −6 | 583 | C |
| ATOM | 1319 | N | ASP | A | 208 | 8.483 | 74.580 | 41.510 | 1.00 | 28.56 | | N |
| ANISOU | 1319 | N | ASP | A | 208 | 3707 | 2815 | 4329 | 206 | 109 | 498 | N |
| ATOM | 1320 | CA | ASP | A | 208 | 8.202 | 73.157 | 41.316 | 1.00 | 30.55 | | C |
| ANISOU | 1320 | CA | ASP | A | 208 | 3968 | 2888 | 4753 | 209 | 87 | 506 | C |
| ATOM | 1321 | C | ASP | A | 208 | 8.978 | 72.659 | 40.121 | 1.00 | 29.84 | | C |
| ANISOU | 1321 | C | ASP | A | 208 | 3814 | 2701 | 4823 | 319 | 118 | 364 | C |
| ATOM | 1322 | O | ASP | A | 208 | 9.498 | 71.556 | 40.136 | 1.00 | 30.50 | | O |
| ANISOU | 1322 | O | ASP | A | 208 | 3868 | 2614 | 5105 | 371 | 69 | 387 | O |
| ATOM | 1323 | CB | ASP | A | 208 | 6.704 | 72.898 | 41.119 | 1.00 | 32.05 | | C |
| ANISOU | 1323 | CB | ASP | A | 208 | 4203 | 3076 | 4899 | 117 | 137 | 461 | C |
| ATOM | 1324 | CG | ASP | A | 208 | 5.893 | 73.148 | 42.384 | 1.00 | 38.96 | | C |
| ANISOU | 1324 | CG | ASP | A | 208 | 5134 | 4024 | 5647 | −3 | 132 | 601 | C |
| ATOM | 1325 | OD1 | ASP | A | 208 | 6.506 | 73.306 | 43.457 | 1.00 | 41.52 | | O |
| ANISOU | 1325 | OD1 | ASP | A | 208 | 5486 | 4376 | 5915 | −19 | 72 | 748 | O |
| ATOM | 1326 | OD2 | ASP | A | 208 | 4.647 | 73.223 | 42.303 | 1.00 | 38.21 | | O |
| ANISOU | 1326 | OD2 | ASP | A | 208 | 5050 | 3965 | 5502 | −84 | 191 | 557 | O |
| ATOM | 1327 | N | ASN | A | 209 | 9.076 | 73.489 | 39.088 | 1.00 | 32.58 | | N |
| ANISOU | 1327 | N | ASN | A | 209 | 4143 | 3154 | 5083 | 354 | 203 | 215 | N |
| ATOM | 1328 | CA | ASN | A | 209 | 9.785 | 73.078 | 37.882 | 1.00 | 28.14 | | C |
| ANISOU | 1328 | CA | ASN | A | 209 | 3532 | 2524 | 4636 | 446 | 265 | 58 | C |
| ATOM | 1329 | C | ASN | A | 209 | 11.241 | 73.507 | 37.886 | 1.00 | 32.40 | | C |
| ANISOU | 1329 | C | ASN | A | 209 | 3981 | 3092 | 5239 | 528 | 276 | 64 | C |
| ATOM | 1330 | O | ASN | A | 209 | 11.936 | 73.336 | 36.895 | 1.00 | 27.33 | | O |
| ANISOU | 1330 | O | ASN | A | 209 | 3285 | 2421 | 4678 | 601 | 359 | −75 | O |
| ATOM | 1331 | CB | ASN | A | 209 | 9.065 | 73.601 | 36.645 | 1.00 | 26.88 | | C |
| ANISOU | 1331 | CB | ASN | A | 209 | 3419 | 2453 | 4340 | 427 | 352 | −108 | C |
| ATOM | 1332 | CG | ASN | A | 209 | 7.736 | 72.891 | 36.413 | 1.00 | 33.67 | | C |
| ANISOU | 1332 | CG | ASN | A | 209 | 4338 | 3245 | 5210 | 363 | 332 | −154 | C |
| ATOM | 1333 | OD1 | ASN | A | 209 | 7.695 | 71.808 | 35.818 | 1.00 | 33.84 | | O |
| ANISOU | 1333 | OD1 | ASN | A | 209 | 4361 | 3126 | 5372 | 390 | 338 | −253 | O |
| ATOM | 1334 | ND2 | ASN | A | 209 | 6.648 | 73.484 | 36.898 | 1.00 | 21.71 | | N |
| ANISOU | 1334 | ND2 | ASN | A | 209 | 2860 | 1822 | 3568 | 276 | 311 | −95 | N |
| ATOM | 1335 | N | ALA | A | 210 | 11.697 | 74.082 | 38.998 | 1.00 | 37.19 | | N |
| ANISOU | 1335 | N | ALA | A | 210 | 4566 | 3759 | 5805 | 508 | 198 | 215 | N |
| ATOM | 1336 | CA | ALA | A | 210 | 13.113 | 74.401 | 39.151 | 1.00 | 31.34 | | C |
| ANISOU | 1336 | CA | ALA | A | 210 | 3717 | 3028 | 5164 | 579 | 179 | 236 | C |
| ATOM | 1337 | C | ALA | A | 210 | 13.668 | 73.982 | 40.506 | 1.00 | 31.91 | | C |
| ANISOU | 1337 | C | ALA | A | 210 | 3760 | 3031 | 5334 | 583 | 18 | 423 | C |
| ATOM | 1338 | O | ALA | A | 210 | 14.063 | 74.840 | 41.294 | 1.00 | 33.07 | | O |
| ANISOU | 1338 | O | ALA | A | 210 | 3898 | 3282 | 5386 | 551 | −46 | 516 | O |
| ATOM | 1339 | CB | ALA | A | 210 | 13.335 | 75.858 | 38.949 | 1.00 | 22.85 | | C |
| ANISOU | 1339 | CB | ALA | A | 210 | 2635 | 2127 | 3920 | 549 | 238 | 207 | C |
| ATOM | 1340 | N | PRO | A | 211 | 13.733 | 72.660 | 40.768 | 1.00 | 28.43 | | N |
| ANISOU | 1340 | N | PRO | A | 211 | 3312 | 2404 | 5088 | 621 | −59 | 479 | N |
| ATOM | 1341 | CA | PRO | A | 211 | 14.213 | 72.154 | 42.062 | 1.00 | 29.38 | | C |
| ANISOU | 1341 | CA | PRO | A | 211 | 3427 | 2439 | 5298 | 621 | −240 | 683 | C |
| ATOM | 1342 | C | PRO | A | 211 | 15.668 | 72.513 | 42.361 | 1.00 | 30.65 | | C |
| ANISOU | 1342 | C | PRO | A | 211 | 3450 | 2609 | 5586 | 701 | −323 | 717 | C |
| ATOM | 1343 | O | PRO | A | 211 | 16.079 | 72.423 | 43.513 | 1.00 | 32.72 | | O |
| ANISOU | 1343 | O | PRO | A | 211 | 3720 | 2851 | 5860 | 685 | −496 | 896 | O |
| ATOM | 1344 | CB | PRO | A | 211 | 14.049 | 70.624 | 41.933 | 1.00 | 32.00 | | C |
| ANISOU | 1344 | CB | PRO | A | 211 | 3764 | 2535 | 5860 | 665 | −285 | 700 | C |
| ATOM | 1345 | CG | PRO | A | 211 | 14.141 | 70.365 | 40.461 | 1.00 | 30.80 | | C |
| ANISOU | 1345 | CG | PRO | A | 211 | 3547 | 2338 | 5816 | 741 | −131 | 460 | C |
| ATOM | 1346 | CD | PRO | A | 211 | 13.447 | 71.570 | 39.820 | 1.00 | 27.18 | | C |
| ANISOU | 1346 | CD | PRO | A | 211 | 3148 | 2092 | 5087 | 671 | 7 | 348 | C |
| ATOM | 1347 | N | GLN | A | 212 | 16.432 | 72.931 | 41.355 | 1.00 | 28.75 | | N |
| ANISOU | 1347 | N | GLN | A | 212 | 3087 | 2406 | 5431 | 776 | −204 | 551 | N |
| ATOM | 1348 | CA | GLN | A | 212 | 17.817 | 73.344 | 41.585 | 1.00 | 29.32 | | C |
| ANISOU | 1348 | CA | GLN | A | 212 | 3000 | 2496 | 5646 | 843 | −267 | 568 | C |
| ATOM | 1349 | C | GLN | A | 212 | 17.866 | 74.717 | 42.309 | 1.00 | 36.26 | | C |
| ANISOU | 1349 | C | GLN | A | 212 | 3915 | 3566 | 6297 | 753 | −315 | 646 | C |
| ATOM | 1350 | O | GLN | A | 212 | 18.938 | 75.187 | 42.685 | 1.00 | 37.38 | | O |
| ANISOU | 1350 | O | GLN | A | 212 | 3935 | 3739 | 6530 | 782 | −396 | 679 | O |
| ATOM | 1351 | CB | GLN | A | 212 | 18.590 | 73.407 | 40.266 | 1.00 | 29.79 | | C |
| ANISOU | 1351 | CB | GLN | A | 212 | 2914 | 2547 | 5858 | 932 | −90 | 358 | C |
| ATOM | 1352 | CG | GLN | A | 212 | 18.098 | 74.490 | 39.288 | 1.00 | 34.09 | | C |
| ANISOU | 1352 | CG | GLN | A | 212 | 3520 | 3265 | 6167 | 868 | 108 | 218 | C |
| ATOM | 1353 | CD | GLN | A | 212 | 16.893 | 74.068 | 38.450 | 1.00 | 31.77 | | C |
| ANISOU | 1353 | CD | GLN | A | 212 | 3362 | 2955 | 5755 | 836 | 221 | 113 | C |
| ATOM | 1354 | OE1 | GLN | A | 212 | 16.153 | 73.161 | 38.820 | 1.00 | 37.00 | | O |
| ANISOU | 1354 | OE1 | GLN | A | 212 | 4105 | 3505 | 6448 | 825 | 144 | 171 | O |
| ATOM | 1355 | NE2 | GLN | A | 212 | 16.707 | 74.721 | 37.306 | 1.00 | 27.41 | | N |
| ANISOU | 1355 | NE2 | GLN | A | 212 | 2838 | 2509 | 5068 | 816 | 395 | −39 | N |
| ATOM | 1356 | N | LEU | A | 213 | 16.708 | 75.354 | 42.493 | 1.00 | 29.44 | | N |
| ANISOU | 1356 | N | LEU | A | 213 | 3206 | 2821 | 5158 | 646 | −266 | 661 | N |
| ATOM | 1357 | CA | LEU | A | 213 | 16.622 | 76.636 | 43.195 | 1.00 | 32.12 | | C |
| ANISOU | 1357 | CA | LEU | A | 213 | 3595 | 3327 | 5282 | 559 | −303 | 716 | C |
| ATOM | 1358 | C | LEU | A | 213 | 15.989 | 76.493 | 44.576 | 1.00 | 33.24 | | C |
| ANISOU | 1358 | C | LEU | A | 213 | 3871 | 3487 | 5270 | 472 | −447 | 889 | C |
| ATOM | 1359 | O | LEU | A | 213 | 15.069 | 75.697 | 44.758 | 1.00 | 31.38 | | O |
| ANISOU | 1359 | O | LEU | A | 213 | 3738 | 3186 | 5001 | 438 | −443 | 941 | O |
| ATOM | 1360 | CB | LEU | A | 213 | 15.801 | 77.644 | 42.382 | 1.00 | 23.37 | | C |
| ANISOU | 1360 | CB | LEU | A | 213 | 2555 | 2349 | 3978 | 505 | −133 | 590 | C |
| ATOM | 1361 | CG | LEU | A | 213 | 16.214 | 78.057 | 40.971 | 1.00 | 27.78 | | C |
| ANISOU | 1361 | CG | LEU | A | 213 | 3034 | 2934 | 4589 | 552 | 36 | 424 | C |
| ATOM | 1362 | CD1 | LEU | A | 213 | 15.170 | 78.972 | 40.394 | 1.00 | 25.44 | | C |
| ANISOU | 1362 | CD1 | LEU | A | 213 | 2846 | 2749 | 4071 | 484 | 148 | 351 | C |
| ATOM | 1363 | CD2 | LEU | A | 213 | 17.532 | 78.784 | 40.989 | 1.00 | 32.03 | | C |
| ANISOU | 1363 | CD2 | LEU | A | 213 | 3429 | 3516 | 5224 | 577 | 25 | 413 | C |
| ATOM | 1364 | N | LYS | A | 214 | 16.479 | 77.263 | 45.548 | 1.00 | 25.80 | | N |
| ANISOU | 1364 | N | LYS | A | 214 | 2934 | 2639 | 4230 | 425 | −567 | 973 | N |
| ATOM | 1365 | CA | LYS | A | 214 | 15.775 | 77.414 | 46.811 | 1.00 | 25.94 | | C |
| ANISOU | 1365 | CA | LYS | A | 214 | 3108 | 2724 | 4024 | 317 | −661 | 1106 | C |
| ATOM | 1366 | C | LYS | A | 214 | 14.538 | 78.271 | 46.584 | 1.00 | 24.09 | | C |
| ANISOU | 1366 | C | LYS | A | 214 | 2977 | 2617 | 3560 | 233 | −503 | 1014 | C |
| ATOM | 1367 | O | LYS | A | 214 | 14.527 | 79.113 | 45.699 | 1.00 | 22.81 | | O |
| ANISOU | 1367 | O | LYS | A | 214 | 2763 | 2517 | 3385 | 252 | −380 | 876 | O |
| ATOM | 1368 | CB | LYS | A | 214 | 16.676 | 78.028 | 47.872 | 1.00 | 39.84 | | C |
| ANISOU | 1368 | CB | LYS | A | 214 | 4850 | 4553 | 5733 | 288 | −841 | 1198 | C |
| ATOM | 1369 | CG | LYS | A | 214 | 17.879 | 77.165 | 48.157 | 1.00 | 44.64 | | C |
| ANISOU | 1369 | CG | LYS | A | 214 | 5342 | 5027 | 6592 | 376 | −1031 | 1300 | C |
| ATOM | 1370 | CD | LYS | A | 214 | 18.612 | 77.569 | 49.407 | 1.00 | 52.00 | | C |
| ANISOU | 1370 | CD | LYS | A | 214 | 6292 | 6018 | 7449 | 331 | −1262 | 1427 | C |
| ATOM | 1371 | CE | LYS | A | 214 | 19.836 | 76.671 | 49.593 | 1.00 | 59.74 | | C |
| ANISOU | 1371 | CE | LYS | A | 214 | 7126 | 6844 | 8728 | 438 | −1470 | 1527 | C |
| ATOM | 1372 | NZ | LYS | A | 214 | 19.508 | 75.251 | 49.268 | 1.00 | 58.83 | | N |
| ANISOU | 1372 | NZ | LYS | A | 214 | 7025 | 6544 | 8785 | 504 | −1462 | 1590 | N |
| ATOM | 1373 | N | GLN | A | 215 | 13.492 | 78.033 | 47.362 | 1.00 | 24.19 | | N |
| ANISOU | 1373 | N | GLN | A | 215 | 3131 | 2659 | 3403 | 141 | −504 | 1094 | N |
| ATOM | 1374 | CA | GLN | A | 215 | 12.221 | 78.717 | 47.178 | 1.00 | 27.26 | | C |
| ANISOU | 1374 | CA | GLN | A | 215 | 3597 | 3150 | 3612 | 69 | −355 | 1004 | C |
| ATOM | 1375 | C | GLN | A | 215 | 12.252 | 80.087 | 47.814 | 1.00 | 26.49 | | C |
| ANISOU | 1375 | C | GLN | A | 215 | 3535 | 3203 | 3327 | 8 | −361 | 969 | C |
| ATOM | 1376 | O | GLN | A | 215 | 11.639 | 80.329 | 48.862 | 1.00 | 25.61 | | O |
| ANISOU | 1376 | O | GLN | A | 215 | 3536 | 3172 | 3023 | −89 | −375 | 1024 | O |
| ATOM | 1377 | CB | GLN | A | 215 | 11.074 | 77.901 | 47.766 | 1.00 | 31.44 | | C |
| ANISOU | 1377 | CB | GLN | A | 215 | 4241 | 3649 | 4055 | −15 | −330 | 1092 | C |
| ATOM | 1378 | CG | GLN | A | 215 | 11.060 | 76.489 | 47.298 | 1.00 | 44.29 | | C |
| ANISOU | 1378 | CG | GLN | A | 215 | 5845 | 5103 | 5878 | 33 | −348 | 1141 | C |
| ATOM | 1379 | CD | GLN | A | 215 | 9.820 | 75.757 | 47.746 | 1.00 | 53.43 | | C |
| ANISOU | 1379 | CD | GLN | A | 215 | 7107 | 6228 | 6965 | −67 | −295 | 1214 | C |
| ATOM | 1380 | OE1 | GLN | A | 215 | 8.713 | 76.299 | 47.704 | 1.00 | 58.04 | | O |
| ANISOU | 1380 | OE1 | GLN | A | 215 | 7729 | 6909 | 7414 | −138 | −170 | 1137 | O |
| ATOM | 1381 | NE2 | GLN | A | 215 | 9.999 | 74.531 | 48.209 | 1.00 | 53.26 | | N |
| ANISOU | 1381 | NE2 | GLN | A | 215 | 7125 | 6063 | 7047 | −76 | −394 | 1368 | N |
| ATOM | 1382 | N | VAL | A | 216 | 12.987 | 80.982 | 47.177 | 1.00 | 28.62 | | N |
| ANISOU | 1382 | N | VAL | A | 216 | 3711 | 3508 | 3657 | 58 | −343 | 871 | N |
| ATOM | 1383 | CA | VAL | A | 216 | 13.121 | 82.340 | 47.642 | 1.00 | 25.83 | | C |
| ANISOU | 1383 | CA | VAL | A | 216 | 3376 | 3272 | 3166 | 7 | −351 | 818 | C |
| ATOM | 1384 | C | VAL | A | 216 | 13.156 | 83.212 | 46.415 | 1.00 | 27.37 | | C |
| ANISOU | 1384 | C | VAL | A | 216 | 3496 | 3482 | 3420 | 51 | −230 | 679 | C |
| ATOM | 1385 | O | VAL | A | 216 | 13.893 | 82.921 | 45.480 | 1.00 | 27.94 | | O |
| ANISOU | 1385 | O | VAL | A | 216 | 3467 | 3492 | 3659 | 125 | −206 | 649 | O |
| ATOM | 1386 | CB | VAL | A | 216 | 14.407 | 82.550 | 48.476 | 1.00 | 26.14 | | C |
| ANISOU | 1386 | CB | VAL | A | 216 | 3375 | 3325 | 3233 | 4 | −530 | 894 | C |
| ATOM | 1387 | CG1 | VAL | A | 216 | 14.592 | 84.027 | 48.839 | 1.00 | 22.15 | | C |
| ANISOU | 1387 | CG1 | VAL | A | 216 | 2878 | 2928 | 2608 | −50 | −536 | 811 | C |
| ATOM | 1388 | CG2 | VAL | A | 216 | 14.420 | 81.649 | 49.719 | 1.00 | 24.20 | | C |
| ANISOU | 1388 | CG2 | VAL | A | 216 | 3226 | 3061 | 2910 | −44 | −681 | 1060 | C |
| ATOM | 1389 | N | PHE | A | 217 | 12.346 | 84.261 | 46.398 | 1.00 | 29.23 | | N |
| ANISOU | 1389 | N | PHE | A | 217 | 3786 | 3796 | 3524 | 5 | −149 | 594 | N |
| ATOM | 1390 | CA | PHE | A | 217 | 12.515 | 85.289 | 45.379 | 1.00 | 24.23 | | C |
| ANISOU | 1390 | CA | PHE | A | 217 | 3098 | 3177 | 2931 | 33 | −68 | 489 | C |
| ATOM | 1391 | C | PHE | A | 217 | 12.689 | 86.656 | 46.020 | 1.00 | 22.91 | | C |
| ANISOU | 1391 | C | PHE | A | 217 | 2952 | 3084 | 2669 | −22 | −101 | 445 | C |
| ATOM | 1392 | O | PHE | A | 217 | 12.160 | 86.963 | 47.094 | 1.00 | 26.65 | | O |
| ANISOU | 1392 | O | PHE | A | 217 | 3508 | 3618 | 3000 | −86 | −133 | 448 | O |
| ATOM | 1393 | CB | PHE | A | 217 | 11.363 | 85.273 | 44.350 | 1.00 | 20.47 | | C |
| ANISOU | 1393 | CB | PHE | A | 217 | 2650 | 2688 | 2441 | 53 | 58 | 412 | C |
| ATOM | 1394 | CG | PHE | A | 217 | 10.036 | 85.753 | 44.862 | 1.00 | 17.88 | | C |
| ANISOU | 1394 | CG | PHE | A | 217 | 2401 | 2415 | 1980 | −1 | 102 | 371 | C |
| ATOM | 1395 | CD2 | PHE | A | 217 | 9.631 | 87.066 | 44.650 | 1.00 | 22.48 | | C |
| ANISOU | 1395 | CD2 | PHE | A | 217 | 2992 | 3036 | 2511 | −13 | 144 | 284 | C |
| ATOM | 1396 | CD1 | PHE | A | 217 | 9.151 | 84.874 | 45.457 | 1.00 | 19.28 | | C |
| ANISOU | 1396 | CD1 | PHE | A | 217 | 2630 | 2589 | 2106 | −37 | 115 | 414 | C |
| ATOM | 1397 | CE2 | PHE | A | 217 | 8.396 | 87.508 | 45.085 | 1.00 | 25.21 | | C |
| ANISOU | 1397 | CE2 | PHE | A | 217 | 3386 | 3424 | 2770 | −50 | 193 | 227 | C |
| ATOM | 1398 | CE1 | PHE | A | 217 | 7.903 | 85.310 | 45.910 | 1.00 | 24.64 | | C |
| ANISOU | 1398 | CE1 | PHE | A | 217 | 3357 | 3323 | 2682 | −90 | 180 | 361 | C |
| ATOM | 1399 | CZ | PHE | A | 217 | 7.522 | 86.616 | 45.717 | 1.00 | 25.20 | | C |
| ANISOU | 1399 | CZ | PHE | A | 217 | 3422 | 3435 | 2717 | −88 | 221 | 259 | C |
| ATOM | 1400 | N | THR | A | 218 | 13.518 | 87.440 | 45.361 | 1.00 | 23.04 | | N |
| ANISOU | 1400 | N | THR | A | 218 | 2891 | 3090 | 2772 | −3 | −89 | 402 | N |
| ATOM | 1401 | CA | THR | A | 218 | 13.905 | 88.728 | 45.839 | 1.00 | 23.14 | | C |
| ANISOU | 1401 | CA | THR | A | 218 | 2904 | 3145 | 2743 | −53 | −131 | 357 | C |
| ATOM | 1402 | C | THR | A | 218 | 13.567 | 89.770 | 44.811 | 1.00 | 24.73 | | C |
| ANISOU | 1402 | C | THR | A | 218 | 3102 | 3332 | 2964 | −46 | −27 | 276 | C |
| ATOM | 1403 | O | THR | A | 218 | 13.862 | 89.609 | 43.629 | 1.00 | 22.04 | | O |
| ANISOU | 1403 | O | THR | A | 218 | 2709 | 2951 | 2713 | −4 | 47 | 272 | O |
| ATOM | 1404 | CB | THR | A | 218 | 15.399 | 88.758 | 46.161 | 1.00 | 24.54 | | C |
| ANISOU | 1404 | CB | THR | A | 218 | 2980 | 3312 | 3034 | −56 | −245 | 401 | C |
| ATOM | 1405 | OG1 | THR | A | 218 | 15.616 | 87.926 | 47.300 | 1.00 | 26.52 | | O |
| ANISOU | 1405 | OG1 | THR | A | 218 | 3261 | 3577 | 3238 | −72 | −380 | 489 | O |
| ATOM | 1406 | CG2 | THR | A | 218 | 15.862 | 90.192 | 46.489 | 1.00 | 24.96 | | C |
| ANISOU | 1406 | CG2 | THR | A | 218 | 3019 | 3392 | 3071 | −116 | −284 | 338 | C |
| ATOM | 1407 | N | ILE | A | 219 | 12.936 | 90.840 | 45.274 | 1.00 | 23.25 | | N |
| ANISOU | 1407 | N | ILE | A | 219 | 2976 | 3173 | 2686 | −89 | −23 | 210 | N |
| ATOM | 1408 | CA | ILE | A | 219 | 12.714 | 91.981 | 44.426 | 1.00 | 19.68 | | C |
| ANISOU | 1408 | CA | ILE | A | 219 | 2524 | 2688 | 2265 | −87 | 42 | 149 | C |
| ATOM | 1409 | C | ILE | A | 219 | 13.624 | 93.109 | 44.857 | 1.00 | 22.71 | | C |
| ANISOU | 1409 | C | ILE | A | 219 | 2874 | 3065 | 2687 | −140 | −21 | 121 | C |
| ATOM | 1410 | O | ILE | A | 219 | 13.733 | 93.432 | 46.043 | 1.00 | 23.57 | | O |
| ANISOU | 1410 | O | ILE | A | 219 | 3013 | 3213 | 2729 | −188 | −105 | 93 | O |
| ATOM | 1411 | CB | ILE | A | 219 | 11.268 | 92.414 | 44.462 | 1.00 | 20.97 | | C |
| ANISOU | 1411 | CB | ILE | A | 219 | 2762 | 2857 | 2348 | −82 | 95 | 81 | C |
| ATOM | 1412 | CG1 | ILE | A | 219 | 10.433 | 91.265 | 43.882 | 1.00 | 17.80 | | C |
| ANISOU | 1412 | CG1 | ILE | A | 219 | 2374 | 2452 | 1937 | −37 | 152 | 107 | C |
| ATOM | 1413 | CG2 | ILE | A | 219 | 11.101 | 93.740 | 43.699 | 1.00 | 15.91 | | C |
| ANISOU | 1413 | CG2 | ILE | A | 219 | 2128 | 2163 | 1756 | −81 | 126 | 29 | C |
| ATOM | 1414 | CD1 | ILE | A | 219 | 8.946 | 91.468 | 43.930 | 1.00 | 15.16 | | C |
| ANISOU | 1414 | CD1 | ILE | A | 219 | 2084 | 2125 | 1551 | −30 | 201 | 43 | C |
| ATOM | 1415 | N | CYS | A | 220 | 14.310 | 93.683 | 43.882 | 1.00 | 22.19 | | N |
| ANISOU | 1415 | N | CYS | A | 220 | 2752 | 2953 | 2727 | −141 | 20 | 129 | N |
| ATOM | 1416 | CA | CYS | A | 220 | 15.276 | 94.725 | 44.166 | 1.00 | 23.68 | | C |
| ANISOU | 1416 | CA | CYS | A | 220 | 2889 | 3119 | 2988 | −202 | −35 | 109 | C |
| ATOM | 1417 | C | CYS | A | 220 | 15.032 | 95.878 | 43.177 | 1.00 | 29.82 | | C |
| ANISOU | 1417 | C | CYS | A | 220 | 3692 | 3829 | 3809 | −216 | 41 | 87 | C |
| ATOM | 1418 | O | CYS | A | 220 | 15.518 | 95.857 | 42.037 | 1.00 | 31.98 | | O |
| ANISOU | 1418 | O | CYS | A | 220 | 3925 | 4072 | 4152 | −211 | 121 | 133 | O |
| ATOM | 1419 | CB | CYS | A | 220 | 16.715 | 94.177 | 44.073 | 1.00 | 22.39 | | C |
| ANISOU | 1419 | CB | CYS | A | 220 | 2596 | 2959 | 2953 | −208 | −72 | 167 | C |
| ATOM | 1420 | SG | CYS | A | 220 | 17.991 | 95.316 | 44.759 | 1.00 | 56.20 | | S |
| ANISOU | 1420 | SG | CYS | A | 220 | 6789 | 7223 | 7342 | −300 | −184 | 138 | S |
| ATOM | 1421 | N | ILE | A | 221 | 14.239 | 96.863 | 43.589 | 1.00 | 22.85 | | N |
| ANISOU | 1421 | N | ILE | A | 221 | 2883 | 2918 | 2882 | −234 | 21 | 16 | N |
| ATOM | 1422 | CA | ILE | A | 221 | 13.914 | 97.932 | 42.658 | 1.00 | 28.79 | | C |
| ANISOU | 1422 | CA | ILE | A | 221 | 3670 | 3584 | 3684 | −240 | 71 | 11 | C |
| ATOM | 1423 | C | ILE | A | 221 | 14.775 | 99.194 | 42.893 | 1.00 | 29.37 | | C |
| ANISOU | 1423 | C | ILE | A | 221 | 3712 | 3590 | 3859 | −320 | 25 | −12 | C |
| ATOM | 1424 | O | ILE | A | 221 | 15.135 | 99.514 | 44.039 | 1.00 | 21.92 | | O |
| ANISOU | 1424 | O | ILE | A | 221 | 2753 | 2664 | 2913 | −364 | −63 | −78 | O |
| ATOM | 1425 | CB | ILE | A | 221 | 12.394 | 98.295 | 42.701 | 1.00 | 45.50 | | C |
| ANISOU | 1425 | CB | ILE | A | 221 | 5873 | 5674 | 5739 | −193 | 83 | −52 | C |
| ATOM | 1426 | CG1 | ILE | A | 221 | 12.034 | 98.964 | 44.002 | 1.00 | 43.79 | | C |
| ANISOU | 1426 | CG1 | ILE | A | 221 | 5684 | 5462 | 5494 | −220 | 24 | −165 | C |
| ATOM | 1427 | CG2 | ILE | A | 221 | 11.460 | 97.062 | 42.451 | 1.00 | 16.70 | | C |
| ANISOU | 1427 | CG2 | ILE | A | 221 | 2248 | 2087 | 2010 | −126 | 127 | −34 | C |
| ATOM | 1428 | CD1 | ILE | A | 221 | 10.963 | 99.976 | 43.805 | 1.00 | 48.30 | | C |
| ANISOU | 1428 | CD1 | ILE | A | 221 | 6304 | 5947 | 6100 | −190 | 36 | −239 | C |
| ATOM | 1429 | N | SER | A | 222 | 15.148 | 99.855 | 41.787 | 1.00 | 21.43 | | N |
| ANISOU | 1429 | N | SER | A | 222 | 2701 | 2507 | 2934 | −348 | 83 | 47 | N |
| ATOM | 1430 | CA | SER | A | 222 | 15.780 | 101.193 | 41.793 | 1.00 | 25.92 | | C |
| ANISOU | 1430 | CA | SER | A | 222 | 3255 | 2977 | 3618 | −432 | 54 | 36 | C |
| ATOM | 1431 | C | SER | A | 222 | 14.782 | 102.282 | 41.374 | 1.00 | 20.90 | | C |
| ANISOU | 1431 | C | SER | A | 222 | 2720 | 2227 | 2995 | −417 | 53 | 17 | C |
| ATOM | 1432 | O | SER | A | 222 | 13.625 | 101.964 | 41.139 | 1.00 | 20.12 | | O |
| ANISOU | 1432 | O | SER | A | 222 | 2686 | 2138 | 2819 | −338 | 67 | 4 | O |
| ATOM | 1433 | CB | SER | A | 222 | 16.978 | 101.230 | 40.845 | 1.00 | 34.47 | | C |
| ANISOU | 1433 | CB | SER | A | 222 | 4257 | 4042 | 4797 | −495 | 131 | 131 | C |
| ATOM | 1434 | OG | SER | A | 222 | 17.993 | 100.354 | 41.279 | 1.00 | 48.05 | | O |
| ANISOU | 1434 | OG | SER | A | 222 | 5854 | 5845 | 6558 | −505 | 117 | 136 | O |
| ATOM | 1435 | N | GLU | A | 223 | 15.231 | 103.550 | 41.268 | 1.00 | 29.95 | | N |
| ANISOU | 1435 | N | GLU | A | 223 | 3869 | 3251 | 4260 | −492 | 27 | 17 | N |
| ATOM | 1436 | CA | GLU | A | 223 | 14.393 | 104.642 | 40.703 | 1.00 | 22.61 | | C |
| ANISOU | 1436 | CA | GLU | A | 223 | 3033 | 2177 | 3380 | −476 | 15 | 27 | C |
| ATOM | 1437 | C | GLU | A | 223 | 13.945 | 104.264 | 39.306 | 1.00 | 32.22 | | C |
| ANISOU | 1437 | C | GLU | A | 223 | 4314 | 3394 | 4534 | −436 | 87 | 154 | C |
| ATOM | 1438 | O | GLU | A | 223 | 12.825 | 104.541 | 38.899 | 1.00 | 31.74 | | O |
| ANISOU | 1438 | O | GLU | A | 223 | 4333 | 3273 | 4453 | −368 | 60 | 157 | O |
| ATOM | 1439 | CB | GLU | A | 223 | 15.135 | 105.986 | 40.579 | 1.00 | 24.21 | | C |
| ANISOU | 1439 | CB | GLU | A | 223 | 3231 | 2229 | 3739 | −580 | −13 | 47 | C |
| ATOM | 1440 | CG | GLU | A | 223 | 15.186 | 106.884 | 41.785 | 1.00 | 40.03 | | C |
| ANISOU | 1440 | CG | GLU | A | 223 | 5221 | 4157 | 5831 | −617 | −111 | −102 | C |
| ATOM | 1441 | CD | GLU | A | 223 | 13.869 | 107.057 | 42.525 | 1.00 | 42.76 | | C |
| ANISOU | 1441 | CD | GLU | A | 223 | 5627 | 4487 | 6132 | −523 | −157 | −244 | C |
| ATOM | 1442 | OE1 | GLU | A | 223 | 12.793 | 107.311 | 41.912 | 1.00 | 24.67 | | O |
| ANISOU | 1442 | OE1 | GLU | A | 223 | 3402 | 2122 | 3849 | −444 | −149 | −222 | O |
| ATOM | 1443 | OE2 | GLU | A | 223 | 13.937 | 106.936 | 43.764 | 1.00 | 41.89 | | O |
| ANISOU | 1443 | OE2 | GLU | A | 223 | 5493 | 4445 | 5979 | −534 | −204 | −386 | O |
| ATOM | 1444 | N | ASN | A | 224 | 14.872 | 103.672 | 38.563 | 1.00 | 34.63 | | N |
| ANISOU | 1444 | N | ASN | A | 224 | 4577 | 3763 | 4817 | −482 | 176 | 251 | N |
| ATOM | 1445 | CA | ASN | A | 224 | 14.627 | 103.203 | 37.211 | 1.00 | 30.54 | | C |
| ANISOU | 1445 | CA | ASN | A | 224 | 4127 | 3270 | 4209 | −460 | 259 | 362 | C |
| ATOM | 1446 | C | ASN | A | 224 | 14.914 | 101.716 | 37.066 | 1.00 | 24.18 | | C |
| ANISOU | 1446 | C | ASN | A | 224 | 3263 | 2612 | 3312 | −419 | 333 | 359 | C |
| ATOM | 1447 | O | ASN | A | 224 | 16.077 | 101.298 | 37.104 | 1.00 | 29.73 | | O |
| ANISOU | 1447 | O | ASN | A | 224 | 3864 | 3370 | 4063 | −470 | 397 | 373 | O |
| ATOM | 1448 | CB | ASN | A | 224 | 15.487 | 103.978 | 36.223 | 1.00 | 25.65 | | C |
| ANISOU | 1448 | CB | ASN | A | 224 | 3531 | 2572 | 3643 | −569 | 333 | 485 | C |
| ATOM | 1449 | CG | ASN | A | 224 | 15.228 | 105.463 | 36.282 | 1.00 | 38.38 | | C |
| ANISOU | 1449 | CG | ASN | A | 224 | 5209 | 4008 | 5367 | −616 | 253 | 506 | C |
| ATOM | 1450 | OD1 | ASN | A | 224 | 14.132 | 105.921 | 35.933 | 1.00 | 36.66 | | O |
| ANISOU | 1450 | OD1 | ASN | A | 224 | 5099 | 3704 | 5127 | −555 | 183 | 527 | O |
| ATOM | 1451 | ND2 | ASN | A | 224 | 16.233 | 106.232 | 36.724 | 1.00 | 33.65 | | N |
| ANISOU | 1451 | ND2 | ASN | A | 224 | 4537 | 3338 | 4910 | −723 | 250 | 498 | N |
| ATOM | 1452 | N | GLY | A | 225 | 13.858 | 100.936 | 36.851 | 1.00 | 20.39 | | N |
| ANISOU | 1452 | N | GLY | A | 225 | 2839 | 2183 | 2725 | −327 | 322 | 340 | N |
| ATOM | 1453 | CA | GLY | A | 225 | 13.968 | 99.502 | 36.679 | 1.00 | 19.28 | | C |
| ANISOU | 1453 | CA | GLY | A | 225 | 2659 | 2158 | 2507 | −280 | 383 | 330 | C |
| ATOM | 1454 | C | GLY | A | 225 | 14.556 | 98.847 | 37.913 | 1.00 | 25.26 | | C |
| ANISOU | 1454 | C | GLY | A | 225 | 3302 | 2982 | 3312 | −275 | 351 | 263 | C |
| ATOM | 1455 | O | GLY | A | 225 | 14.626 | 99.440 | 38.998 | 1.00 | 28.12 | | O |
| ANISOU | 1455 | O | GLY | A | 225 | 3637 | 3320 | 3729 | −298 | 269 | 205 | O |
| ATOM | 1456 | N | GLY | A | 226 | 14.978 | 97.606 | 37.766 | 1.00 | 26.56 | | N |
| ANISOU | 1456 | N | GLY | A | 226 | 3409 | 3228 | 3455 | −244 | 405 | 267 | N |
| ATOM | 1457 | CA | GLY | A | 226 | 15.534 | 96.897 | 38.898 | 1.00 | 27.13 | | C |
| ANISOU | 1457 | CA | GLY | A | 226 | 3380 | 3355 | 3572 | −233 | 352 | 227 | C |
| ATOM | 1458 | C | GLY | A | 226 | 15.728 | 95.450 | 38.545 | 1.00 | 24.44 | | C |
| ANISOU | 1458 | C | GLY | A | 226 | 2997 | 3076 | 3213 | −178 | 408 | 237 | C |
| ATOM | 1459 | O | GLY | A | 226 | 15.979 | 95.116 | 37.387 | 1.00 | 18.33 | | O |
| ANISOU | 1459 | O | GLY | A | 226 | 2230 | 2307 | 2426 | −173 | 517 | 265 | O |
| ATOM | 1460 | N | GLU | A | 227 | 15.569 | 94.583 | 39.531 | 1.00 | 17.59 | | N |
| ANISOU | 1460 | N | GLU | A | 227 | 2098 | 2248 | 2336 | −138 | 336 | 212 | N |
| ATOM | 1461 | CA | GLU | A | 227 | 15.828 | 93.177 | 39.293 | 1.00 | 20.94 | | C |
| ANISOU | 1461 | CA | GLU | A | 227 | 2472 | 2707 | 2779 | −82 | 374 | 222 | C |
| ATOM | 1462 | C | GLU | A | 227 | 14.967 | 92.280 | 40.156 | 1.00 | 18.78 | | C |
| ANISOU | 1462 | C | GLU | A | 227 | 2238 | 2458 | 2439 | −36 | 301 | 209 | C |
| ATOM | 1463 | O | GLU | A | 227 | 14.680 | 92.592 | 41.322 | 1.00 | 23.87 | | O |
| ANISOU | 1463 | O | GLU | A | 227 | 2904 | 3119 | 3047 | −58 | 207 | 195 | O |
| ATOM | 1464 | CB | GLU | A | 227 | 17.305 | 92.871 | 39.533 | 1.00 | 21.48 | | C |
| ANISOU | 1464 | CB | GLU | A | 227 | 2389 | 2780 | 2991 | −100 | 370 | 238 | C |
| ATOM | 1465 | CG | GLU | A | 227 | 17.740 | 91.469 | 39.126 | 1.00 | 26.05 | | C |
| ANISOU | 1465 | CG | GLU | A | 227 | 2894 | 3368 | 3636 | −34 | 424 | 240 | C |
| ATOM | 1466 | CD | GLU | A | 227 | 19.251 | 91.283 | 39.224 | 1.00 | 36.51 | | C |
| ANISOU | 1466 | CD | GLU | A | 227 | 4039 | 4687 | 5145 | −45 | 430 | 247 | C |
| ATOM | 1467 | OE1 | GLU | A | 227 | 19.946 | 91.639 | 38.244 | 1.00 | 40.10 | | O |
| ANISOU | 1467 | OE1 | GLU | A | 227 | 4433 | 5137 | 5664 | −77 | 566 | 237 | O |
| ATOM | 1468 | OE2 | GLU | A | 227 | 19.745 | 90.787 | 40.270 | 1.00 | 32.17 | | O |
| ANISOU | 1468 | OE2 | GLU | A | 227 | 3407 | 4138 | 4679 | −26 | 299 | 265 | O |
| ATOM | 1469 | N | LEU | A | 228 | 14.543 | 91.181 | 39.541 | 1.00 | 22.90 | | N |
| ANISOU | 1469 | N | LEU | A | 228 | 2779 | 2983 | 2940 | 19 | 353 | 209 | N |
| ATOM | 1470 | CA | LEU | A | 228 | 13.919 | 90.048 | 40.216 | 1.00 | 26.53 | | C |
| ANISOU | 1470 | CA | LEU | A | 228 | 3258 | 3454 | 3371 | 57 | 303 | 213 | C |
| ATOM | 1471 | C | LEU | A | 228 | 14.888 | 88.851 | 40.261 | 1.00 | 27.25 | | C |
| ANISOU | 1471 | C | LEU | A | 228 | 3251 | 3528 | 3574 | 96 | 298 | 241 | C |
| ATOM | 1472 | O | LEU | A | 228 | 15.416 | 88.410 | 39.237 | 1.00 | 23.38 | | O |
| ANISOU | 1472 | O | LEU | A | 228 | 2714 | 3018 | 3151 | 127 | 391 | 222 | O |
| ATOM | 1473 | CB | LEU | A | 228 | 12.623 | 89.632 | 39.510 | 1.00 | 27.76 | | C |
| ANISOU | 1473 | CB | LEU | A | 228 | 3501 | 3602 | 3446 | 89 | 349 | 184 | C |
| ATOM | 1474 | CG | LEU | A | 228 | 11.999 | 88.300 | 39.962 | 1.00 | 27.68 | | C |
| ANISOU | 1474 | CG | LEU | A | 228 | 3502 | 3587 | 3429 | 120 | 323 | 192 | C |
| ATOM | 1475 | CD1 | LEU | A | 228 | 11.442 | 88.381 | 41.368 | 1.00 | 25.29 | | C |
| ANISOU | 1475 | CD1 | LEU | A | 228 | 3227 | 3312 | 3069 | 87 | 247 | 209 | C |
| ATOM | 1476 | CD2 | LEU | A | 228 | 10.918 | 87.868 | 38.992 | 1.00 | 25.23 | | C |
| ANISOU | 1476 | CD2 | LEU | A | 228 | 3253 | 3261 | 3073 | 147 | 373 | 151 | C |
| ATOM | 1477 | N | ILE | A | 229 | 15.104 | 88.327 | 41.458 | 1.00 | 28.49 | | N |
| ANISOU | 1477 | N | ILE | A | 229 | 3383 | 3690 | 3752 | 95 | 189 | 283 | N |
| ATOM | 1478 | CA | ILE | A | 229 | 15.962 | 87.179 | 41.629 | 1.00 | 25.07 | | C |
| ANISOU | 1478 | CA | ILE | A | 229 | 2856 | 3221 | 3448 | 141 | 150 | 322 | C |
| ATOM | 1479 | C | ILE | A | 229 | 15.184 | 85.954 | 42.144 | 1.00 | 24.73 | | C |
| ANISOU | 1479 | C | ILE | A | 229 | 2873 | 3151 | 3372 | 170 | 102 | 361 | C |
| ATOM | 1480 | O | ILE | A | 229 | 14.437 | 86.036 | 43.114 | 1.00 | 25.13 | | O |
| ANISOU | 1480 | O | ILE | A | 229 | 3007 | 3233 | 3308 | 129 | 36 | 393 | O |
| ATOM | 1481 | CB | ILE | A | 229 | 17.097 | 87.491 | 42.603 | 1.00 | 27.68 | | C |
| ANISOU | 1481 | CB | ILE | A | 229 | 3094 | 3562 | 3863 | 115 | 25 | 365 | C |
| ATOM | 1482 | CG1 | ILE | A | 229 | 17.773 | 88.805 | 42.219 | 1.00 | 26.70 | | C |
| ANISOU | 1482 | CG1 | ILE | A | 229 | 2913 | 3457 | 3774 | 65 | 67 | 327 | C |
| ATOM | 1483 | CG2 | ILE | A | 229 | 18.073 | 86.330 | 42.641 | 1.00 | 27.96 | | C |
| ANISOU | 1483 | CG2 | ILE | A | 229 | 3003 | 3540 | 4078 | 179 | −24 | 404 | C |
| ATOM | 1484 | CD1 | ILE | A | 229 | 18.728 | 89.304 | 43.265 | 1.00 | 22.19 | | C |
| ANISOU | 1484 | CD1 | ILE | A | 229 | 2262 | 2901 | 3268 | 19 | −77 | 354 | C |
| ATOM | 1485 | N | ALA | A | 230 | 15.354 | 84.817 | 41.485 | 1.00 | 19.88 | | N |
| ANISOU | 1485 | N | ALA | A | 230 | 2218 | 2474 | 2861 | 232 | 147 | 353 | N |
| ATOM | 1486 | CA | ALA | A | 230 | 14.817 | 83.563 | 42.013 | 1.00 | 21.23 | | C |
| ANISOU | 1486 | CA | ALA | A | 230 | 2431 | 2592 | 3045 | 255 | 88 | 407 | C |
| ATOM | 1487 | C | ALA | A | 230 | 15.944 | 82.690 | 42.544 | 1.00 | 20.01 | | C |
| ANISOU | 1487 | C | ALA | A | 230 | 2172 | 2369 | 3063 | 302 | −17 | 476 | C |
| ATOM | 1488 | O | ALA | A | 230 | 16.951 | 82.513 | 41.871 | 1.00 | 21.15 | | O |
| ANISOU | 1488 | O | ALA | A | 230 | 2192 | 2475 | 3370 | 357 | 26 | 434 | O |
| ATOM | 1489 | CB | ALA | A | 230 | 14.053 | 82.825 | 40.959 | 1.00 | 19.84 | | C |
| ANISOU | 1489 | CB | ALA | A | 230 | 2294 | 2370 | 2875 | 290 | 190 | 342 | C |
| ATOM | 1490 | N | GLY | A | 231 | 15.759 | 82.143 | 43.742 | 1.00 | 24.85 | | N |
| ANISOU | 1490 | N | GLY | A | 231 | 3170 | 3293 | 2979 | 557 | −534 | 753 | N |
| ATOM | 1491 | CA | GLY | A | 231 | 16.718 | 81.227 | 44.344 | 1.00 | 21.58 | | C |
| ANISOU | 1491 | CA | GLY | A | 231 | 2757 | 2829 | 2615 | 615 | −654 | 740 | C |
| ATOM | 1492 | C | GLY | A | 231 | 17.407 | 81.750 | 45.590 | 1.00 | 27.24 | | C |
| ANISOU | 1492 | C | GLY | A | 231 | 3410 | 3531 | 3407 | 607 | −784 | 703 | C |
| ATOM | 1493 | O | GLY | A | 231 | 18.097 | 80.986 | 46.277 | 1.00 | 23.21 | | O |
| ANISOU | 1493 | O | GLY | A | 231 | 2936 | 2960 | 2921 | 661 | −938 | 681 | O |
| ATOM | 1494 | N | GLY | A | 232 | 17.221 | 83.046 | 45.881 | 1.00 | 24.96 | | N |
| ANISOU | 1494 | N | GLY | A | 232 | 3044 | 3285 | 3153 | 549 | −745 | 691 | N |
| ATOM | 1495 | CA | GLY | A | 232 | 17.842 | 83.715 | 47.017 | 1.00 | 22.56 | | C |
| ANISOU | 1495 | CA | GLY | A | 232 | 2686 | 2961 | 2927 | 543 | −877 | 648 | C |
| ATOM | 1496 | C | GLY | A | 232 | 17.898 | 85.234 | 46.842 | 1.00 | 30.97 | | C |
| ANISOU | 1496 | C | GLY | A | 232 | 3610 | 4066 | 4090 | 498 | −784 | 630 | C |
| ATOM | 1497 | O | GLY | A | 232 | 17.133 | 85.814 | 46.073 | 1.00 | 26.53 | | O |
| ANISOU | 1497 | O | GLY | A | 232 | 3049 | 3555 | 3475 | 455 | −632 | 658 | O |
| ATOM | 1498 | N | TYR | A | 233 | 18.794 | 85.885 | 47.575 | 1.00 | 30.27 | | N |
| ANISOU | 1498 | N | TYR | A | 233 | 3413 | 3941 | 4148 | 514 | −898 | 576 | N |
| ATOM | 1499 | CA | TYR | A | 233 | 19.108 | 87.282 | 47.340 | 1.00 | 28.14 | | C |
| ANISOU | 1499 | CA | TYR | A | 233 | 2983 | 3688 | 4020 | 479 | −810 | 550 | C |
| ATOM | 1500 | C | TYR | A | 233 | 20.591 | 87.398 | 47.019 | 1.00 | 29.72 | | C |
| ANISOU | 1500 | C | TYR | A | 233 | 2958 | 3813 | 4520 | 542 | −816 | 482 | C |
| ATOM | 1501 | O | TYR | A | 233 | 21.350 | 86.456 | 47.223 | 1.00 | 31.82 | | O |
| ANISOU | 1501 | O | TYR | A | 233 | 3194 | 4016 | 4880 | 619 | −941 | 444 | O |
| ATOM | 1502 | CB | TYR | A | 233 | 18.749 | 88.140 | 48.551 | 1.00 | 28.82 | | C |
| ANISOU | 1502 | CB | TYR | A | 233 | 3128 | 3785 | 4039 | 426 | −929 | 532 | C |
| ATOM | 1503 | CG | TYR | A | 233 | 19.510 | 87.758 | 49.798 | 1.00 | 32.09 | | C |
| ANISOU | 1503 | CG | TYR | A | 233 | 3585 | 4113 | 4494 | 480 | −1191 | 477 | C |
| ATOM | 1504 | CD1 | TYR | A | 233 | 19.063 | 86.728 | 50.617 | 1.00 | 26.05 | | C |
| ANISOU | 1504 | CD1 | TYR | A | 233 | 3059 | 3312 | 3525 | 497 | −1323 | 498 | C |
| ATOM | 1505 | CD2 | TYR | A | 233 | 20.679 | 88.427 | 50.157 | 1.00 | 25.85 | | C |
| ANISOU | 1505 | CD2 | TYR | A | 233 | 2614 | 3256 | 3952 | 517 | −1318 | 394 | C |
| ATOM | 1506 | CE1 | TYR | A | 233 | 19.758 | 86.367 | 51.761 | 1.00 | 27.51 | | C |
| ANISOU | 1506 | CE1 | TYR | A | 233 | 3345 | 3390 | 3717 | 564 | −1591 | 445 | C |
| ATOM | 1507 | CE2 | TYR | A | 233 | 21.375 | 88.081 | 51.297 | 1.00 | 27.67 | | C |
| ANISOU | 1507 | CE2 | TYR | A | 233 | 2904 | 3383 | 4225 | 587 | −1609 | 327 | C |
| ATOM | 1508 | CZ | TYR | A | 233 | 20.915 | 87.043 | 52.096 | 1.00 | 30.85 | | C |
| ANISOU | 1508 | CZ | TYR | A | 233 | 3590 | 3745 | 4387 | 618 | −1754 | 356 | C |
| ATOM | 1509 | OH | TYR | A | 233 | 21.614 | 86.681 | 53.228 | 1.00 | 36.53 | | O |
| ANISOU | 1509 | OH | TYR | A | 233 | 4427 | 4334 | 5119 | 705 | −2069 | 286 | O |
| ATOM | 1510 | N | ASP | A | 234 | 21.005 | 88.544 | 46.502 | 1.00 | 28.87 | | N |
| ANISOU | 1510 | N | ASP | A | 234 | 2690 | 3700 | 4580 | 510 | −674 | 458 | N |
| ATOM | 1511 | CA | ASP | A | 234 | 22.409 | 88.726 | 46.195 | 1.00 | 30.65 | | C |
| ANISOU | 1511 | CA | ASP | A | 234 | 2670 | 3835 | 5141 | 552 | −640 | 377 | C |
| ATOM | 1512 | C | ASP | A | 234 | 23.067 | 89.606 | 47.247 | 1.00 | 36.66 | | C |
| ANISOU | 1512 | C | ASP | A | 234 | 3292 | 4547 | 6089 | 538 | −824 | 294 | C |
| ATOM | 1513 | O | ASP | A | 234 | 22.794 | 90.812 | 47.317 | 1.00 | 37.68 | | O |
| ANISOU | 1513 | O | ASP | A | 234 | 3394 | 4701 | 6221 | 467 | −755 | 299 | O |
| ATOM | 1514 | CB | ASP | A | 234 | 22.588 | 89.341 | 44.813 | 1.00 | 27.44 | | C |
| ANISOU | 1514 | CB | ASP | A | 234 | 2183 | 3412 | 4832 | 526 | −316 | 397 | C |
| ATOM | 1515 | CG | ASP | A | 234 | 24.006 | 89.184 | 44.293 | 1.00 | 36.45 | | C |
| ANISOU | 1515 | CG | ASP | A | 234 | 3080 | 4440 | 6328 | 573 | −208 | 313 | C |
| ATOM | 1516 | OD1 | ASP | A | 234 | 24.926 | 89.033 | 45.126 | 1.00 | 39.54 | | O |
| ANISOU | 1516 | OD1 | ASP | A | 234 | 3295 | 4768 | 6963 | 613 | −415 | 216 | O |
| ATOM | 1517 | OD2 | ASP | A | 234 | 24.210 | 89.237 | 43.059 | 1.00 | 36.59 | | O |
| ANISOU | 1517 | OD2 | ASP | A | 234 | 3091 | 4416 | 6396 | 575 | 86 | 334 | O |
| ATOM | 1518 | N | PRO | A | 235 | 23.960 | 89.010 | 48.046 | 1.00 | 31.95 | | N |
| ANISOU | 1518 | N | PRO | A | 235 | 2615 | 3865 | 5659 | 615 | −1080 | 208 | N |
| ATOM | 1519 | CA | PRO | A | 235 | 24.665 | 89.723 | 49.120 | 1.00 | 35.95 | | C |
| ANISOU | 1519 | CA | PRO | A | 235 | 3005 | 4294 | 6360 | 626 | −1326 | 107 | C |
| ATOM | 1520 | C | PRO | A | 235 | 25.528 | 90.854 | 48.564 | 1.00 | 39.16 | | C |
| ANISOU | 1520 | C | PRO | A | 235 | 3110 | 4645 | 7125 | 582 | −1161 | 34 | C |
| ATOM | 1521 | O | PRO | A | 235 | 25.761 | 91.859 | 49.242 | 1.00 | 40.16 | | O |
| ANISOU | 1521 | O | PRO | A | 235 | 3160 | 4737 | 7364 | 547 | −1280 | −23 | O |
| ATOM | 1522 | CB | PRO | A | 235 | 25.524 | 88.633 | 49.776 | 1.00 | 32.41 | | C |
| ANISOU | 1522 | CB | PRO | A | 235 | 2540 | 3740 | 6033 | 742 | −1614 | 18 | C |
| ATOM | 1523 | CG | PRO | A | 235 | 24.917 | 87.324 | 49.315 | 1.00 | 38.43 | | C |
| ANISOU | 1523 | CG | PRO | A | 235 | 3488 | 4552 | 6559 | 780 | −1552 | 106 | C |
| ATOM | 1524 | CD | PRO | A | 235 | 24.374 | 87.605 | 47.945 | 1.00 | 29.93 | | C |
| ANISOU | 1524 | CD | PRO | A | 235 | 2384 | 3565 | 5424 | 710 | −1173 | 191 | C |
| ATOM | 1525 | N | ALA | A | 236 | 25.967 | 90.695 | 47.321 | 1.00 | 38.14 | | N |
| ANISOU | 1525 | N | ALA | A | 236 | 2836 | 4494 | 7161 | 578 | −868 | 36 | N |
| ATOM | 1526 | CA | ALA | A | 236 | 26.823 | 91.677 | 46.677 | 1.00 | 36.67 | | C |
| ANISOU | 1526 | CA | ALA | A | 236 | 2377 | 4226 | 7329 | 526 | −642 | −33 | C |
| ATOM | 1527 | C | ALA | A | 236 | 26.124 | 93.031 | 46.449 | 1.00 | 32.44 | | C |
| ANISOU | 1527 | C | ALA | A | 236 | 1919 | 3746 | 6660 | 417 | −466 | 32 | C |
| ATOM | 1528 | O | ALA | A | 236 | 26.799 | 94.043 | 46.340 | 1.00 | 44.43 | | O |
| ANISOU | 1528 | O | ALA | A | 236 | 3233 | 5186 | 8463 | 363 | −366 | −38 | O |
| ATOM | 1529 | CB | ALA | A | 236 | 27.351 | 91.120 | 45.361 | 1.00 | 34.43 | | C |
| ANISOU | 1529 | CB | ALA | A | 236 | 1992 | 3890 | 7199 | 549 | −321 | −33 | C |
| ATOM | 1530 | N | TYR | A | 237 | 24.794 | 93.043 | 46.366 | 1.00 | 30.19 | | N |
| ANISOU | 1530 | N | TYR | A | 237 | 1917 | 3583 | 5970 | 387 | −431 | 152 | N |
| ATOM | 1531 | CA | TYR | A | 237 | 24.027 | 94.294 | 46.209 | 1.00 | 29.06 | | C |
| ANISOU | 1531 | CA | TYR | A | 237 | 1869 | 3492 | 5680 | 300 | −304 | 208 | C |
| ATOM | 1532 | C | TYR | A | 237 | 23.865 | 95.029 | 47.527 | 1.00 | 29.88 | | C |
| ANISOU | 1532 | C | TYR | A | 237 | 1982 | 3609 | 5762 | 275 | −571 | 169 | C |
| ATOM | 1533 | O | TYR | A | 237 | 23.409 | 96.162 | 47.549 | 1.00 | 30.64 | | O |
| ANISOU | 1533 | O | TYR | A | 237 | 2117 | 3730 | 5793 | 207 | −500 | 191 | O |
| ATOM | 1534 | CB | TYR | A | 237 | 22.618 | 94.063 | 45.660 | 1.00 | 26.92 | | C |
| ANISOU | 1534 | CB | TYR | A | 237 | 1878 | 3332 | 5020 | 287 | −195 | 328 | C |
| ATOM | 1535 | CG | TYR | A | 237 | 22.515 | 93.416 | 44.300 | 1.00 | 37.47 | | C |
| ANISOU | 1535 | CG | TYR | A | 237 | 3291 | 4653 | 6292 | 317 | 57 | 382 | C |
| ATOM | 1536 | CD1 | TYR | A | 237 | 23.619 | 93.317 | 43.453 | 1.00 | 30.20 | | C |
| ANISOU | 1536 | CD1 | TYR | A | 237 | 2209 | 3623 | 5644 | 335 | 273 | 337 | C |
| ATOM | 1537 | CD2 | TYR | A | 237 | 21.299 | 92.892 | 43.864 | 1.00 | 30.79 | | C |
| ANISOU | 1537 | CD2 | TYR | A | 237 | 2687 | 3888 | 5124 | 331 | 81 | 468 | C |
| ATOM | 1538 | CE1 | TYR | A | 237 | 23.512 | 92.703 | 42.207 | 1.00 | 29.20 | | C |
| ANISOU | 1538 | CE1 | TYR | A | 237 | 2202 | 3466 | 5426 | 372 | 511 | 388 | C |
| ATOM | 1539 | CE2 | TYR | A | 237 | 21.185 | 92.286 | 42.631 | 1.00 | 32.59 | | C |
| ANISOU | 1539 | CE2 | TYR | A | 237 | 3020 | 4087 | 5276 | 372 | 278 | 512 | C |
| ATOM | 1540 | CZ | TYR | A | 237 | 22.291 | 92.191 | 41.805 | 1.00 | 35.63 | | C |
| ANISOU | 1540 | CZ | TYR | A | 237 | 3284 | 4361 | 5892 | 396 | 495 | 478 | C |
| ATOM | 1541 | OH | TYR | A | 237 | 22.160 | 91.590 | 40.574 | 1.00 | 26.90 | | O |
| ANISOU | 1541 | OH | TYR | A | 237 | 2331 | 3211 | 4680 | 445 | 700 | 523 | O |
| ATOM | 1542 | N | ILE | A | 238 | 24.165 | 94.357 | 48.629 | 1.00 | 32.98 | | N |
| ANISOU | 1542 | N | ILE | A | 238 | 2386 | 3975 | 6169 | 338 | −886 | 114 | N |
| ATOM | 1543 | CA | ILE | A | 238 | 23.857 | 94.914 | 49.938 | 1.00 | 37.45 | | C |
| ANISOU | 1543 | CA | ILE | A | 238 | 3054 | 4544 | 6631 | 330 | −1152 | 88 | C |
| ATOM | 1544 | C | ILE | A | 238 | 24.786 | 96.087 | 50.281 | 1.00 | 40.29 | | C |
| ANISOU | 1544 | C | ILE | A | 238 | 3182 | 4805 | 7322 | 299 | −1222 | −18 | C |
| ATOM | 1545 | O | ILE | A | 238 | 25.982 | 96.051 | 49.991 | 1.00 | 33.22 | | O |
| ANISOU | 1545 | O | ILE | A | 238 | 2078 | 3800 | 6743 | 310 | −1181 | −117 | O |
| ATOM | 1546 | CB | ILE | A | 238 | 23.923 | 93.816 | 51.017 | 1.00 | 37.51 | | C |
| ANISOU | 1546 | CB | ILE | A | 238 | 3209 | 4517 | 6527 | 420 | −1476 | 60 | C |
| ATOM | 1547 | CG1 | ILE | A | 238 | 22.854 | 92.764 | 50.726 | 1.00 | 28.50 | | C |
| ANISOU | 1547 | CG1 | ILE | A | 238 | 2313 | 3470 | 5044 | 427 | −1384 | 170 | C |
| ATOM | 1548 | CG2 | ILE | A | 238 | 23.717 | 94.396 | 52.409 | 1.00 | 34.88 | | C |
| ANISOU | 1548 | CG2 | ILE | A | 238 | 3024 | 4148 | 6082 | 425 | −1755 | 24 | C |
| ATOM | 1549 | CD1 | ILE | A | 238 | 22.784 | 91.672 | 51.770 | 1.00 | 29.03 | | C |
| ANISOU | 1549 | CD1 | ILE | A | 238 | 2590 | 3492 | 4948 | 504 | −1662 | 160 | C |
| ATOM | 1550 | N | VAL | A | 239 | 24.219 | 97.139 | 50.870 | 1.00 | 41.96 | | N |
| ANISOU | 1550 | N | VAL | A | 239 | 3493 | 5046 | 7404 | 245 | −1276 | −3 | N |
| ATOM | 1551 | CA | VAL | A | 239 | 24.982 | 98.330 | 51.235 | 1.00 | 38.38 | | C |
| ANISOU | 1551 | CA | VAL | A | 239 | 2878 | 4498 | 7206 | 203 | −1331 | −100 | C |
| ATOM | 1552 | C | VAL | A | 239 | 26.030 | 98.001 | 52.299 | 1.00 | 47.33 | | C |
| ANISOU | 1552 | C | VAL | A | 239 | 4023 | 5496 | 8465 | 270 | −1617 | −230 | C |
| ATOM | 1553 | O | VAL | A | 239 | 25.747 | 97.270 | 53.246 | 1.00 | 40.21 | | O |
| ANISOU | 1553 | O | VAL | A | 239 | 3337 | 4590 | 7351 | 339 | −1862 | −229 | O |
| ATOM | 1554 | CB | VAL | A | 239 | 24.051 | 99.465 | 51.741 | 1.00 | 36.94 | | C |
| ANISOU | 1554 | CB | VAL | A | 239 | 2837 | 4377 | 6820 | 144 | −1358 | −53 | C |
| ATOM | 1555 | CG1 | VAL | A | 239 | 24.843 | 100.584 | 52.414 | 1.00 | 36.13 | | C |
| ANISOU | 1555 | CG1 | VAL | A | 239 | 2640 | 4161 | 6926 | 117 | −1482 | −161 | C |
| ATOM | 1556 | CG2 | VAL | A | 239 | 23.220 | 100.007 | 50.602 | 1.00 | 29.31 | | C |
| ANISOU | 1556 | CG2 | VAL | A | 239 | 1933 | 3504 | 5700 | 68 | −1005 | 50 | C |
| ATOM | 1557 | O | ARG | A | 240 | 29.830 | 96.637 | 51.963 | 1.00 | 69.17 | | O |
| ANISOU | 1557 | O | ARG | A | 240 | 6284 | 7852 | 12146 | 383 | −1720 | −586 | O |
| ATOM | 1558 | N | ARG | A | 240 | 27.230 | 98.558 | 52.113 | 1.00 | 57.46 | | N |
| ANISOU | 1558 | N | ARG | A | 240 | 5089 | 6647 | 10096 | 247 | −1570 | −342 | N |
| ATOM | 1559 | CA | ARG | A | 240 | 28.403 | 98.309 | 52.953 | 1.00 | 66.96 | | C |
| ANISOU | 1559 | CA | ARG | A | 240 | 6247 | 7683 | 11511 | 311 | −1826 | −489 | C |
| ATOM | 1560 | C | ARG | A | 240 | 28.926 | 96.885 | 52.768 | 1.00 | 71.50 | | C |
| ANISOU | 1560 | C | ARG | A | 240 | 6802 | 8221 | 12143 | 391 | −1882 | −523 | C |
| ATOM | 1561 | CB | ARG | A | 240 | 28.096 | 98.571 | 54.429 | 1.00 | 67.68 | | C |
| ANISOU | 1561 | CB | ARG | A | 240 | 6581 | 7733 | 11402 | 358 | −2161 | −517 | C |
| ATOM | 1562 | CG | ARG | A | 240 | 27.821 | 100.018 | 54.763 | 1.00 | 72.36 | | C |
| ANISOU | 1562 | CG | ARG | A | 240 | 7178 | 8323 | 11992 | 292 | −2154 | −518 | C |
| ATOM | 1563 | CD | ARG | A | 240 | 27.546 | 100.159 | 56.248 | 1.00 | 83.49 | | C |
| ANISOU | 1563 | CD | ARG | A | 240 | 8867 | 9670 | 13186 | 354 | −2479 | −550 | C |
| ATOM | 1564 | NE | ARG | A | 240 | 28.073 | 99.013 | 56.988 | 1.00 | 91.03 | | N |
| ANISOU | 1564 | NE | ARG | A | 240 | 9957 | 10513 | 14118 | 463 | −2731 | −620 | N |
| ATOM | 1565 | CZ | ARG | A | 240 | 27.938 | 98.836 | 58.298 | 1.00 | 91.72 | | C |
| ANISOU | 1565 | CZ | ARG | A | 240 | 10340 | 10504 | 14005 | 540 | −3018 | −655 | C |
| ATOM | 1566 | NH1 | ARG | A | 240 | 27.310 | 99.745 | 59.034 | 1.00 | 89.57 | | N |
| ANISOU | 1566 | NH1 | ARG | A | 240 | 10251 | 10237 | 13543 | 521 | −3086 | −629 | N |
| ATOM | 1567 | NH2 | ARG | A | 240 | 28.442 | 97.754 | 58.874 | 1.00 | 91.94 | | N |
| ANISOU | 1567 | NH2 | ARG | A | 240 | 10500 | 10412 | 14020 | 639 | −3230 | −721 | N |
| ATOM | 1568 | O | ALA | A | 273 | 26.657 | 93.526 | 56.657 | 1.00 | 62.80 | | O |
| ANISOU | 1568 | O | ALA | A | 273 | 6977 | 7116 | 9769 | 677 | −2792 | −395 | O |
| ATOM | 1569 | N | ALA | A | 273 | 29.207 | 95.032 | 56.048 | 1.00 | 59.37 | | N |
| ANISOU | 1569 | N | ALA | A | 273 | 5894 | 6449 | 10215 | 647 | −2790 | −666 | N |
| ATOM | 1570 | CA | ALA | A | 273 | 28.075 | 94.747 | 55.161 | 1.00 | 64.18 | | C |
| ANISOU | 1570 | CA | ALA | A | 273 | 6535 | 7262 | 10587 | 594 | −2528 | −502 | C |
| ATOM | 1571 | C | ALA | A | 273 | 26.783 | 94.512 | 55.936 | 1.00 | 61.06 | | C |
| ANISOU | 1571 | C | ALA | A | 273 | 6503 | 6951 | 9746 | 605 | −2617 | −393 | C |
| ATOM | 1572 | CB | ALA | A | 273 | 28.382 | 93.539 | 54.285 | 1.00 | 66.11 | | C |
| ANISOU | 1572 | CB | ALA | A | 273 | 6673 | 7533 | 10914 | 630 | −2415 | −490 | C |
| ATOM | 1573 | O | GLU | A | 274 | 23.834 | 93.232 | 55.467 | 1.00 | 47.24 | | O |
| ANISOU | 1573 | O | GLU | A | 274 | 5212 | 5511 | 7228 | 562 | −2368 | −74 | O |
| ATOM | 1574 | N | GLU | A | 274 | 25.810 | 95.395 | 55.731 | 1.00 | 53.64 | | N |
| ANISOU | 1574 | N | GLU | A | 274 | 5595 | 6133 | 8652 | 527 | −2470 | −299 | N |
| ATOM | 1575 | CA | GLU | A | 274 | 24.524 | 95.338 | 56.429 | 1.00 | 48.49 | | C |
| ANISOU | 1575 | CA | GLU | A | 274 | 5274 | 5553 | 7595 | 519 | −2511 | −201 | C |
| ATOM | 1576 | C | GLU | A | 274 | 23.796 | 93.999 | 56.422 | 1.00 | 44.85 | | C |
| ANISOU | 1576 | C | GLU | A | 274 | 5039 | 5146 | 6857 | 555 | −2497 | −115 | C |
| ATOM | 1577 | CB | GLU | A | 274 | 23.573 | 96.403 | 55.874 | 1.00 | 50.31 | | C |
| ANISOU | 1577 | CB | GLU | A | 274 | 5442 | 5923 | 7752 | 424 | −2310 | −113 | C |
| ATOM | 1578 | CG | GLU | A | 274 | 23.933 | 97.807 | 56.297 | 1.00 | 53.09 | | C |
| ANISOU | 1578 | CG | GLU | A | 274 | 5713 | 6216 | 8242 | 385 | −2361 | −181 | C |
| ATOM | 1579 | CD | GLU | A | 274 | 22.910 | 98.830 | 55.850 | 1.00 | 53.78 | | C |
| ANISOU | 1579 | CD | GLU | A | 274 | 5781 | 6431 | 8222 | 297 | −2185 | −96 | C |
| ATOM | 1580 | OE1 | GLU | A | 274 | 21.800 | 98.440 | 55.419 | 1.00 | 42.77 | | O |
| ANISOU | 1580 | OE1 | GLU | A | 274 | 4501 | 5160 | 6591 | 268 | −2033 | 13 | O |
| ATOM | 1581 | OE2 | GLU | A | 274 | 23.224 | 100.033 | 55.933 | 1.00 | 60.23 | | O |
| ANISOU | 1581 | OE2 | GLU | A | 274 | 6485 | 7211 | 9187 | 253 | −2178 | −145 | O |
| ATOM | 1582 | N | LYS | A | 275 | 23.092 | 93.769 | 57.518 | 1.00 | 44.17 | | N |
| ANISOU | 1582 | N | LYS | A | 275 | 5313 | 5020 | 6448 | 574 | −2611 | −86 | N |
| ATOM | 1583 | CA | LYS | A | 275 | 22.423 | 92.518 | 57.787 | 1.00 | 35.88 | | C |
| ANISOU | 1583 | CA | LYS | A | 275 | 4545 | 3975 | 5112 | 602 | −2607 | −17 | C |
| ATOM | 1584 | C | LYS | A | 275 | 20.941 | 92.579 | 57.389 | 1.00 | 41.54 | | C |
| ANISOU | 1584 | C | LYS | A | 275 | 5381 | 4841 | 5563 | 523 | −2396 | 118 | C |
| ATOM | 1585 | O | LYS | A | 275 | 20.306 | 93.636 | 57.414 | 1.00 | 45.42 | | O |
| ANISOU | 1585 | O | LYS | A | 275 | 5863 | 5397 | 5997 | 460 | −2319 | 148 | O |
| ATOM | 1586 | CB | LYS | A | 275 | 22.588 | 92.192 | 59.272 | 1.00 | 35.50 | | C |
| ANISOU | 1586 | CB | LYS | A | 275 | 4857 | 3750 | 4881 | 666 | −2829 | −79 | C |
| ATOM | 1587 | CG | LYS | A | 275 | 22.262 | 90.793 | 59.662 | 1.00 | 53.50 | | C |
| ANISOU | 1587 | CG | LYS | A | 275 | 7429 | 5972 | 6928 | 707 | −2852 | −45 | C |
| ATOM | 1588 | CD | LYS | A | 275 | 22.587 | 90.564 | 61.121 | 1.00 | 58.94 | | C |
| ANISOU | 1588 | CD | LYS | A | 275 | 8474 | 6443 | 7476 | 781 | −3080 | −126 | C |
| ATOM | 1589 | CE | LYS | A | 275 | 23.995 | 91.042 | 61.451 | 1.00 | 66.91 | | C |
| ANISOU | 1589 | CE | LYS | A | 275 | 9315 | 7304 | 8803 | 857 | −3336 | −279 | C |
| ATOM | 1590 | NZ | LYS | A | 275 | 25.014 | 90.379 | 60.590 | 1.00 | 68.46 | | N |
| ANISOU | 1590 | NZ | LYS | A | 275 | 9203 | 7502 | 9307 | 899 | −3376 | −340 | N |
| ATOM | 1591 | N | VAL | A | 276 | 20.402 | 91.433 | 56.991 | 1.00 | 46.14 | | N |
| ANISOU | 1591 | N | VAL | A | 276 | 6068 | 5466 | 5995 | 526 | −2305 | 192 | N |
| ATOM | 1592 | CA | VAL | A | 276 | 19.003 | 91.327 | 56.618 | 1.00 | 40.93 | | C |
| ANISOU | 1592 | CA | VAL | A | 276 | 5528 | 4923 | 5099 | 440 | −2063 | 301 | C |
| ATOM | 1593 | C | VAL | A | 276 | 18.082 | 91.343 | 57.844 | 1.00 | 43.95 | | C |
| ANISOU | 1593 | C | VAL | A | 276 | 6304 | 5242 | 5151 | 414 | −2076 | 327 | C |
| ATOM | 1594 | O | VAL | A | 276 | 18.313 | 90.637 | 58.827 | 1.00 | 47.18 | | O |
| ANISOU | 1594 | O | VAL | A | 276 | 6987 | 5515 | 5424 | 466 | −2201 | 294 | O |
| ATOM | 1595 | CB | VAL | A | 276 | 18.758 | 90.053 | 55.803 | 1.00 | 36.23 | | C |
| ANISOU | 1595 | CB | VAL | A | 276 | 4921 | 4375 | 4469 | 443 | −1934 | 357 | C |
| ATOM | 1596 | CG1 | VAL | A | 276 | 17.305 | 89.972 | 55.372 | 1.00 | 38.09 | | C |
| ANISOU | 1596 | CG1 | VAL | A | 276 | 5240 | 4719 | 4512 | 339 | −1638 | 440 | C |
| ATOM | 1597 | CG2 | VAL | A | 276 | 19.656 | 90.053 | 54.600 | 1.00 | 38.43 | | C |
| ANISOU | 1597 | CG2 | VAL | A | 276 | 4847 | 4698 | 5058 | 473 | −1886 | 331 | C |
| ATOM | 1598 | N | VAL | A | 277 | 17.041 | 92.162 | 57.786 | 1.00 | 42.19 | | N |
| ANISOU | 1598 | N | VAL | A | 277 | 6094 | 5109 | 4829 | 317 | −1852 | 362 | N |
| ATOM | 1599 | CA | VAL | A | 277 | 16.028 | 92.163 | 58.830 | 1.00 | 38.21 | | C |
| ANISOU | 1599 | CA | VAL | A | 277 | 5946 | 4547 | 4026 | 274 | −1777 | 386 | C |
| ATOM | 1600 | C | VAL | A | 277 | 14.818 | 91.321 | 58.431 | 1.00 | 35.28 | | C |
| ANISOU | 1600 | C | VAL | A | 277 | 5660 | 4236 | 3508 | 193 | −1498 | 454 | C |
| ATOM | 1601 | O | VAL | A | 277 | 14.136 | 91.618 | 57.449 | 1.00 | 40.46 | | O |
| ANISOU | 1601 | O | VAL | A | 277 | 6093 | 5025 | 4254 | 123 | −1278 | 479 | O |
| ATOM | 1602 | CB | VAL | A | 277 | 15.590 | 93.578 | 59.156 | 1.00 | 36.60 | | C |
| ANISOU | 1602 | CB | VAL | A | 277 | 5716 | 4378 | 3813 | 223 | −1707 | 365 | C |
| ATOM | 1603 | CG1 | VAL | A | 277 | 14.505 | 93.553 | 60.207 | 1.00 | 35.83 | | C |
| ANISOU | 1603 | CG1 | VAL | A | 277 | 5988 | 4209 | 3415 | 176 | −1580 | 384 | C |
| ATOM | 1604 | CG2 | VAL | A | 277 | 16.790 | 94.372 | 59.633 | 1.00 | 37.71 | | C |
| ANISOU | 1604 | CG2 | VAL | A | 277 | 5788 | 4434 | 4107 | 301 | −2003 | 287 | C |
| ATOM | 1605 | N | TRP | A | 278 | 14.567 | 90.269 | 59.199 | 1.00 | 35.23 | | N |
| ANISOU | 1605 | N | TRP | A | 278 | 5994 | 4111 | 3282 | 208 | −1523 | 476 | N |
| ATOM | 1606 | CA | TRP | A | 278 | 13.565 | 89.263 | 58.859 | 1.00 | 39.35 | | C |
| ANISOU | 1606 | CA | TRP | A | 278 | 6600 | 4657 | 3695 | 134 | −1285 | 530 | C |
| ATOM | 1607 | C | TRP | A | 278 | 12.267 | 89.432 | 59.647 | 1.00 | 42.32 | | C |
| ANISOU | 1607 | C | TRP | A | 278 | 7237 | 4983 | 3860 | 36 | −1041 | 542 | C |
| ATOM | 1608 | O | TRP | A | 278 | 12.293 | 89.819 | 60.814 | 1.00 | 48.56 | | O |
| ANISOU | 1608 | O | TRP | A | 278 | 8329 | 5649 | 4474 | 55 | −1106 | 522 | O |
| ATOM | 1609 | CB | TRP | A | 278 | 14.120 | 87.848 | 59.106 | 1.00 | 38.30 | | C |
| ANISOU | 1609 | CB | TRP | A | 278 | 6676 | 4408 | 3470 | 205 | −1436 | 547 | C |
| ATOM | 1610 | CG | TRP | A | 278 | 15.216 | 87.413 | 58.150 | 1.00 | 41.28 | | C |
| ANISOU | 1610 | CG | TRP | A | 278 | 6769 | 4837 | 4078 | 290 | −1603 | 534 | C |
| ATOM | 1611 | CD1 | TRP | A | 278 | 16.552 | 87.277 | 58.433 | 1.00 | 41.08 | | C |
| ANISOU | 1611 | CD1 | TRP | A | 278 | 6682 | 4730 | 4197 | 401 | −1859 | 461 | C |
| ATOM | 1612 | CD2 | TRP | A | 278 | 15.060 | 87.033 | 56.775 | 1.00 | 34.53 | | C |
| ANISOU | 1612 | CD2 | TRP | A | 278 | 5618 | 4115 | 3387 | 262 | −1455 | 563 | C |
| ATOM | 1613 | NE1 | TRP | A | 278 | 17.232 | 86.847 | 57.316 | 1.00 | 36.55 | | N |
| ANISOU | 1613 | NE1 | TRP | A | 278 | 5823 | 4226 | 3837 | 448 | −1903 | 463 | N |
| ATOM | 1614 | CE2 | TRP | A | 278 | 16.341 | 86.699 | 56.284 | 1.00 | 34.08 | | C |
| ANISOU | 1614 | CE2 | TRP | A | 278 | 5382 | 4045 | 3523 | 367 | −1658 | 532 | C |
| ATOM | 1615 | CE3 | TRP | A | 278 | 13.965 | 86.952 | 55.910 | 1.00 | 34.33 | | C |
| ANISOU | 1615 | CE3 | TRP | A | 278 | 5468 | 4201 | 3373 | 166 | −1183 | 602 | C |
| ATOM | 1616 | CZ2 | TRP | A | 278 | 16.553 | 86.296 | 54.971 | 1.00 | 27.21 | | C |
| ANISOU | 1616 | CZ2 | TRP | A | 278 | 4246 | 3269 | 2825 | 375 | −1564 | 549 | C |
| ATOM | 1617 | CZ3 | TRP | A | 278 | 14.175 | 86.549 | 54.601 | 1.00 | 29.31 | | C |
| ANISOU | 1617 | CZ3 | TRP | A | 278 | 4585 | 3655 | 2898 | 184 | −1132 | 618 | C |
| ATOM | 1618 | CH2 | TRP | A | 278 | 15.459 | 86.234 | 54.143 | 1.00 | 27.89 | | C |
| ANISOU | 1618 | CH2 | TRP | A | 278 | 4261 | 3460 | 2877 | 285 | −1305 | 597 | C |
| ATOM | 1619 | N | GLU | A | 279 | 11.136 | 89.130 | 59.011 | 1.00 | 37.62 | | N |
| ANISOU | 1619 | N | GLU | A | 279 | 6531 | 4467 | 3295 | −65 | −761 | 563 | N |
| ATOM | 1620 | CA | GLU | A | 279 | 9.851 | 89.080 | 59.711 | 1.00 | 34.98 | | C |
| ANISOU | 1620 | CA | GLU | A | 279 | 6420 | 4064 | 2806 | −170 | −486 | 560 | C |
| ATOM | 1621 | C | GLU | A | 279 | 8.997 | 87.893 | 59.274 | 1.00 | 32.31 | | C |
| ANISOU | 1621 | C | GLU | A | 279 | 6096 | 3714 | 2465 | −249 | −275 | 585 | C |
| ATOM | 1622 | O | GLU | A | 279 | 8.944 | 87.571 | 58.090 | 1.00 | 31.40 | | O |
| ANISOU | 1622 | O | GLU | A | 279 | 5690 | 3714 | 2526 | −252 | −266 | 593 | O |
| ATOM | 1623 | CB | GLU | A | 279 | 9.038 | 90.357 | 59.491 | 1.00 | 32.47 | | C |
| ANISOU | 1623 | CB | GLU | A | 279 | 5895 | 3846 | 2594 | −235 | −315 | 521 | C |
| ATOM | 1624 | CG | GLU | A | 279 | 9.685 | 91.605 | 60.027 | 1.00 | 45.42 | | C |
| ANISOU | 1624 | CG | GLU | A | 279 | 7550 | 5484 | 4225 | −178 | −481 | 492 | C |
| ATOM | 1625 | CD | GLU | A | 279 | 9.868 | 91.560 | 61.524 | 1.00 | 62.70 | | C |
| ANISOU | 1625 | CD | GLU | A | 279 | 10190 | 7484 | 6149 | −148 | −545 | 486 | C |
| ATOM | 1626 | OE1 | GLU | A | 279 | 9.034 | 90.941 | 62.228 | 1.00 | 64.84 | | O |
| ANISOU | 1626 | OE1 | GLU | A | 279 | 10765 | 7635 | 6236 | −214 | −327 | 497 | O |
| ATOM | 1627 | OE2 | GLU | A | 279 | 10.865 | 92.145 | 61.990 | 1.00 | 69.06 | | O |
| ANISOU | 1627 | OE2 | GLU | A | 279 | 11060 | 8243 | 6938 | −56 | −816 | 466 | O |
| ATOM | 1628 | N | ASN | A | 280 | 8.307 | 87.262 | 60.220 | 1.00 | 33.26 | | N |
| ANISOU | 1628 | N | ASN | A | 280 | 6569 | 3680 | 2388 | −316 | −92 | 593 | N |
| ATOM | 1629 | CA | ASN | A | 280 | 7.330 | 86.238 | 59.854 | 1.00 | 40.19 | | C |
| ANISOU | 1629 | CA | ASN | A | 280 | 7441 | 4531 | 3297 | −418 | 155 | 601 | C |
| ATOM | 1630 | C | ASN | A | 280 | 6.157 | 86.854 | 59.116 | 1.00 | 40.91 | | C |
| ANISOU | 1630 | C | ASN | A | 280 | 7194 | 4740 | 3610 | −515 | 390 | 548 | C |
| ATOM | 1631 | O | ASN | A | 280 | 5.670 | 87.926 | 59.485 | 1.00 | 42.89 | | O |
| ANISOU | 1631 | O | ASN | A | 280 | 7403 | 5009 | 3884 | −548 | 498 | 503 | O |
| ATOM | 1632 | CB | ASN | A | 280 | 6.820 | 85.481 | 61.078 | 1.00 | 38.05 | | C |
| ANISOU | 1632 | CB | ASN | A | 280 | 7643 | 4039 | 2774 | −482 | 346 | 615 | C |
| ATOM | 1633 | CG | ASN | A | 280 | 7.898 | 84.711 | 61.741 | 1.00 | 48.11 | | C |
| ANISOU | 1633 | CG | ASN | A | 280 | 9152 | 5189 | 3937 | −361 | 86 | 613 | C |
| ATOM | 1634 | OD1 | ASN | A | 280 | 8.908 | 84.410 | 61.116 | 1.00 | 55.08 | | O |
| ANISOU | 1634 | OD1 | ASN | A | 280 | 9899 | 6142 | 4886 | −261 | −187 | 637 | O |
| ATOM | 1635 | ND2 | ASN | A | 280 | 7.725 | 84.409 | 63.021 | 1.00 | 56.98 | | N |
| ANISOU | 1635 | ND2 | ASN | A | 280 | 10630 | 6111 | 4907 | −362 | 166 | 572 | N |
| ATOM | 1636 | N | VAL | A | 281 | 5.727 | 86.174 | 58.060 | 1.00 | 38.87 | | N |
| ANISOU | 1636 | N | VAL | A | 281 | 6700 | 4550 | 3520 | −549 | 443 | 544 | N |
| ATOM | 1637 | CA | VAL | A | 281 | 4.506 | 86.529 | 57.360 | 1.00 | 41.03 | | C |
| ANISOU | 1637 | CA | VAL | A | 281 | 6679 | 4894 | 4017 | −636 | 645 | 475 | C |
| ATOM | 1638 | C | VAL | A | 281 | 3.320 | 86.152 | 58.244 | 1.00 | 41.92 | | C |
| ANISOU | 1638 | C | VAL | A | 281 | 6983 | 4854 | 4091 | −773 | 983 | 431 | C |
| ATOM | 1639 | O | VAL | A | 281 | 3.371 | 85.159 | 58.953 | 1.00 | 46.71 | | O |
| ANISOU | 1639 | O | VAL | A | 281 | 7912 | 5311 | 4524 | −810 | 1070 | 470 | O |
| ATOM | 1640 | CB | VAL | A | 281 | 4.421 | 85.826 | 55.997 | 1.00 | 43.87 | | C |
| ANISOU | 1640 | CB | VAL | A | 281 | 6778 | 5338 | 4555 | −619 | 571 | 476 | C |
| ATOM | 1641 | CG1 | VAL | A | 281 | 3.093 | 86.095 | 55.342 | 1.00 | 50.08 | | C |
| ANISOU | 1641 | CG1 | VAL | A | 281 | 7291 | 6156 | 5580 | −700 | 746 | 385 | C |
| ATOM | 1642 | CG2 | VAL | A | 281 | 5.541 | 86.307 | 55.098 | 1.00 | 41.48 | | C |
| ANISOU | 1642 | CG2 | VAL | A | 281 | 6292 | 5168 | 4302 | −492 | 299 | 511 | C |
| ATOM | 1643 | N | THR | A | 282 | 2.269 | 86.958 | 58.234 | 1.00 | 40.91 | | N |
| ANISOU | 1643 | N | THR | A | 282 | 6670 | 4746 | 4125 | −846 | 1185 | 345 | N |
| ATOM | 1644 | CA | THR | A | 282 | 1.157 | 86.750 | 59.158 | 1.00 | 46.86 | | C |
| ANISOU | 1644 | CA | THR | A | 282 | 7595 | 5340 | 4870 | −981 | 1552 | 288 | C |
| ATOM | 1645 | C | THR | A | 282 | −0.041 | 85.983 | 58.567 | 1.00 | 48.79 | | C |
| ANISOU | 1645 | C | THR | A | 282 | 7619 | 5539 | 5378 | −1099 | 1777 | 208 | C |
| ATOM | 1646 | O | THR | A | 282 | −0.988 | 85.666 | 59.288 | 1.00 | 50.49 | | O |
| ANISOU | 1646 | O | THR | A | 282 | 7957 | 5598 | 5629 | −1230 | 2123 | 151 | O |
| ATOM | 1647 | CB | THR | A | 282 | 0.660 | 88.111 | 59.722 | 1.00 | 38.87 | | C |
| ANISOU | 1647 | CB | THR | A | 282 | 6540 | 4337 | 3890 | −999 | 1684 | 219 | C |
| ATOM | 1648 | OG1 | THR | A | 282 | 0.143 | 88.909 | 58.649 | 1.00 | 42.11 | | O |
| ANISOU | 1648 | OG1 | THR | A | 282 | 6506 | 4898 | 4595 | −980 | 1618 | 139 | O |
| ATOM | 1649 | CG2 | THR | A | 282 | 1.810 | 88.882 | 60.375 | 1.00 | 35.14 | | C |
| ANISOU | 1649 | CG2 | THR | A | 282 | 6297 | 3885 | 3168 | −888 | 1457 | 286 | C |
| ATOM | 1650 | N | ARG | A | 283 | −0.006 | 85.676 | 57.272 | 1.00 | 51.35 | | N |
| ANISOU | 1650 | N | ARG | A | 283 | 7635 | 5981 | 5897 | −1054 | 1590 | 196 | N |
| ATOM | 1651 | CA | ARG | A | 283 | −1.065 | 84.866 | 56.655 | 1.00 | 53.84 | | C |
| ANISOU | 1651 | CA | ARG | A | 283 | 7742 | 6239 | 6474 | −1151 | 1742 | 113 | C |
| ATOM | 1652 | C | ARG | A | 283 | −0.461 | 83.845 | 55.701 | 1.00 | 45.70 | | C |
| ANISOU | 1652 | C | ARG | A | 283 | 6671 | 5256 | 5437 | −1088 | 1511 | 177 | C |
| ATOM | 1653 | O | ARG | A | 283 | 0.591 | 84.090 | 55.121 | 1.00 | 45.12 | | O |
| ANISOU | 1653 | O | ARG | A | 283 | 6570 | 5308 | 5267 | −957 | 1221 | 249 | O |
| ATOM | 1654 | CB | ARG | A | 283 | −2.085 | 85.754 | 55.936 | 1.00 | 57.83 | | C |
| ANISOU | 1654 | CB | ARG | A | 283 | 7840 | 6813 | 7319 | −1165 | 1774 | −27 | C |
| ATOM | 1655 | CG | ARG | A | 283 | −2.812 | 86.713 | 56.876 | 1.00 | 62.81 | | C |
| ANISOU | 1655 | CG | ARG | A | 283 | 8488 | 7381 | 7996 | −1236 | 2040 | −109 | C |
| ATOM | 1656 | CD | ARG | A | 283 | −4.147 | 87.154 | 56.325 | 1.00 | 69.01 | | C |
| ANISOU | 1656 | CD | ARG | A | 283 | 8881 | 8155 | 9185 | −1292 | 2162 | −285 | C |
| ATOM | 1657 | NE | ARG | A | 283 | −5.017 | 86.011 | 56.079 | 1.00 | 74.34 | | N |
| ANISOU | 1657 | NE | ARG | A | 283 | 9449 | 8703 | 10094 | −1408 | 2336 | −364 | N |
| ATOM | 1658 | CZ | ARG | A | 283 | −6.020 | 86.006 | 55.208 | 1.00 | 78.19 | | C |
| ANISOU | 1658 | CZ | ARG | A | 283 | 9551 | 9179 | 10977 | −1429 | 2313 | −518 | C |
| ATOM | 1659 | NH1 | ARG | A | 283 | −6.284 | 87.096 | 54.490 | 1.00 | 71.07 | | N |
| ANISOU | 1659 | NH1 | ARG | A | 283 | 8361 | 8384 | 10257 | −1333 | 2118 | −606 | N |
| ATOM | 1660 | NH2 | ARG | A | 283 | −6.757 | 84.908 | 55.055 | 1.00 | 83.77 | | N |
| ANISOU | 1660 | NH2 | ARG | A | 283 | 10173 | 9751 | 11904 | −1542 | 2471 | −592 | N |
| ATOM | 1661 | N | LYS | A | 284 | −1.123 | 82.704 | 55.532 | 1.00 | 45.03 | | N |
| ANISOU | 1661 | N | LYS | A | 284 | 6580 | 5062 | 5469 | −1183 | 1653 | 143 | N |
| ATOM | 1662 | CA | LYS | A | 284 | −0.495 | 81.564 | 54.861 | 1.00 | 45.16 | | C |
| ANISOU | 1662 | CA | LYS | A | 284 | 6652 | 5087 | 5419 | −1130 | 1465 | 216 | C |
| ATOM | 1663 | C | LYS | A | 284 | −0.168 | 81.764 | 53.371 | 1.00 | 42.99 | | C |
| ANISOU | 1663 | C | LYS | A | 284 | 6081 | 4969 | 5286 | −1006 | 1163 | 208 | C |
| ATOM | 1664 | O | LYS | A | 284 | 0.919 | 81.384 | 52.916 | 1.00 | 42.74 | | O |
| ANISOU | 1664 | O | LYS | A | 284 | 6132 | 5003 | 5104 | −896 | 933 | 302 | O |
| ATOM | 1665 | CB | LYS | A | 284 | −1.382 | 80.323 | 55.008 | 1.00 | 49.72 | | C |
| ANISOU | 1665 | CB | LYS | A | 284 | 7281 | 5494 | 6114 | −1273 | 1703 | 170 | C |
| ATOM | 1666 | CG | LYS | A | 284 | −1.184 | 79.574 | 56.313 | 1.00 | 51.68 | | C |
| ANISOU | 1666 | CG | LYS | A | 284 | 7981 | 5562 | 6094 | −1356 | 1924 | 242 | C |
| ATOM | 1667 | CD | LYS | A | 284 | −2.057 | 78.325 | 56.399 | 1.00 | 54.57 | | C |
| ANISOU | 1667 | CD | LYS | A | 284 | 8400 | 5745 | 6590 | −1509 | 2180 | 196 | C |
| ATOM | 1668 | CE | LYS | A | 284 | −3.268 | 78.551 | 57.288 | 1.00 | 55.15 | | C |
| ANISOU | 1668 | CE | LYS | A | 284 | 8467 | 5676 | 6813 | −1640 | 2563 | 74 | C |
| ATOM | 1669 | NZ | LYS | A | 284 | −4.034 | 77.290 | 57.477 | 1.00 | 60.91 | | N |
| ANISOU | 1669 | NZ | LYS | A | 284 | 9247 | 6240 | 7654 | −1732 | 2755 | 9 | N |
| ATOM | 1670 | N | TYR | A | 285 | −1.083 | 82.355 | 52.608 | 1.00 | 37.24 | | N |
| ANISOU | 1670 | N | TYR | A | 285 | 5026 | 4280 | 4843 | −1016 | 1159 | 89 | N |
| ATOM | 1671 | CA | TYR | A | 285 | −0.882 | 82.404 | 51.162 | 1.00 | 43.28 | | C |
| ANISOU | 1671 | CA | TYR | A | 285 | 5576 | 5146 | 5723 | −899 | 885 | 75 | C |
| ATOM | 1672 | C | TYR | A | 285 | −0.712 | 83.813 | 50.631 | 1.00 | 43.05 | | C |
| ANISOU | 1672 | C | TYR | A | 285 | 5375 | 5243 | 5739 | −797 | 735 | 48 | C |
| ATOM | 1673 | O | TYR | A | 285 | −0.626 | 84.017 | 49.423 | 1.00 | 49.37 | | O |
| ANISOU | 1673 | O | TYR | A | 285 | 6027 | 6106 | 6626 | −695 | 525 | 27 | O |
| ATOM | 1674 | CB | TYR | A | 285 | −2.047 | 81.711 | 50.464 | 1.00 | 45.13 | | C |
| ANISOU | 1674 | CB | TYR | A | 285 | 5602 | 5290 | 6257 | −964 | 923 | −49 | C |
| ATOM | 1675 | CG | TYR | A | 285 | −2.299 | 80.368 | 51.085 | 1.00 | 47.98 | | C |
| ANISOU | 1675 | CG | TYR | A | 285 | 6139 | 5505 | 6588 | −1088 | 1117 | −29 | C |
| ATOM | 1676 | CD1 | TYR | A | 285 | −1.350 | 79.353 | 50.987 | 1.00 | 52.93 | | C |
| ANISOU | 1676 | CD1 | TYR | A | 285 | 6993 | 6128 | 6990 | −1039 | 1005 | 94 | C |
| ATOM | 1677 | CD2 | TYR | A | 285 | −3.442 | 80.130 | 51.831 | 1.00 | 49.15 | | C |
| ANISOU | 1677 | CD2 | TYR | A | 285 | 6246 | 5503 | 6925 | −1256 | 1434 | −133 | C |
| ATOM | 1678 | CE1 | TYR | A | 285 | −1.555 | 78.121 | 51.581 | 1.00 | 60.44 | | C |
| ANISOU | 1678 | CE1 | TYR | A | 285 | 8145 | 6931 | 7890 | −1150 | 1179 | 118 | C |
| ATOM | 1679 | CE2 | TYR | A | 285 | −3.657 | 78.897 | 52.433 | 1.00 | 56.91 | | C |
| ANISOU | 1679 | CE2 | TYR | A | 285 | 7429 | 6328 | 7866 | −1381 | 1645 | −110 | C |
| ATOM | 1680 | CZ | TYR | A | 285 | −2.713 | 77.894 | 52.299 | 1.00 | 60.26 | | C |
| ANISOU | 1680 | CZ | TYR | A | 285 | 8098 | 6752 | 8045 | −1325 | 1505 | 20 | C |
| ATOM | 1681 | OH | TYR | A | 285 | −2.922 | 76.668 | 52.890 | 1.00 | 61.50 | | O |
| ANISOU | 1681 | OH | TYR | A | 285 | 8483 | 6739 | 8145 | −1445 | 1706 | 46 | O |
| ATOM | 1682 | N | TYR | A | 286 | −0.590 | 84.771 | 51.540 | 1.00 | 39.13 | | N |
| ANISOU | 1682 | N | TYR | A | 286 | 4945 | 4770 | 5155 | −817 | 838 | 57 | N |
| ATOM | 1683 | CA | TYR | A | 286 | −0.417 | 86.166 | 51.155 | 1.00 | 38.79 | | C |
| ANISOU | 1683 | CA | TYR | A | 286 | 4762 | 4835 | 5142 | −730 | 714 | 34 | C |
| ATOM | 1684 | C | TYR | A | 286 | 0.706 | 86.812 | 51.947 | 1.00 | 40.62 | | C |
| ANISOU | 1684 | C | TYR | A | 286 | 5188 | 5125 | 5122 | −687 | 680 | 138 | C |
| ATOM | 1685 | O | TYR | A | 286 | 1.016 | 86.399 | 53.063 | 1.00 | 47.78 | | O |
| ANISOU | 1685 | O | TYR | A | 286 | 6336 | 5962 | 5856 | −742 | 800 | 192 | O |
| ATOM | 1686 | CB | TYR | A | 286 | −1.697 | 86.957 | 51.369 | 1.00 | 39.11 | | C |
| ANISOU | 1686 | CB | TYR | A | 286 | 4603 | 4834 | 5421 | −796 | 862 | −113 | C |
| ATOM | 1687 | CG | TYR | A | 286 | −2.949 | 86.380 | 50.748 | 1.00 | 40.53 | | C |
| ANISOU | 1687 | CG | TYR | A | 286 | 4557 | 4924 | 5917 | −852 | 905 | −256 | C |
| ATOM | 1688 | CD1 | TYR | A | 286 | −3.156 | 86.451 | 49.383 | 1.00 | 39.58 | | C |
| ANISOU | 1688 | CD1 | TYR | A | 286 | 4252 | 4834 | 5950 | −749 | 656 | −314 | C |
| ATOM | 1689 | CD2 | TYR | A | 286 | −3.944 | 85.805 | 51.536 | 1.00 | 43.59 | | C |
| ANISOU | 1689 | CD2 | TYR | A | 286 | 4923 | 5173 | 6464 | −1005 | 1197 | −344 | C |
| ATOM | 1690 | CE1 | TYR | A | 286 | −4.305 | 85.959 | 48.808 | 1.00 | 42.58 | | C |
| ANISOU | 1690 | CE1 | TYR | A | 286 | 4418 | 5114 | 6645 | −786 | 648 | −464 | C |
| ATOM | 1691 | CE2 | TYR | A | 286 | −5.104 | 85.301 | 50.966 | 1.00 | 46.98 | | C |
| ANISOU | 1691 | CE2 | TYR | A | 286 | 5104 | 5504 | 7241 | −1060 | 1228 | −497 | C |
| ATOM | 1692 | CZ | TYR | A | 286 | −5.273 | 85.381 | 49.598 | 1.00 | 47.29 | | C |
| ANISOU | 1692 | CZ | TYR | A | 286 | 4948 | 5581 | 7440 | −944 | 928 | −561 | C |
| ATOM | 1693 | OH | TYR | A | 286 | −6.410 | 84.903 | 48.992 | 1.00 | 50.54 | | O |
| ANISOU | 1693 | OH | TYR | A | 286 | 5106 | 5879 | 8217 | −981 | 902 | −731 | O |
| ATOM | 1694 | N | TYR | A | 287 | 1.298 | 87.843 | 51.366 | 1.00 | 31.02 | | N |
| ANISOU | 1694 | N | TYR | A | 287 | 3882 | 4015 | 3891 | −584 | 509 | 157 | N |
| ATOM | 1695 | CA | TYR | A | 287 | 2.466 | 88.488 | 51.946 | 1.00 | 29.10 | | C |
| ANISOU | 1695 | CA | TYR | A | 287 | 3779 | 3824 | 3453 | −531 | 430 | 244 | C |
| ATOM | 1696 | C | TYR | A | 287 | 2.087 | 89.668 | 52.849 | 1.00 | 33.36 | | C |
| ANISOU | 1696 | C | TYR | A | 287 | 4331 | 4362 | 3984 | −569 | 541 | 198 | C |
| ATOM | 1697 | O | TYR | A | 287 | 2.197 | 90.834 | 52.459 | 1.00 | 32.71 | | O |
| ANISOU | 1697 | O | TYR | A | 287 | 4125 | 4352 | 3950 | −512 | 455 | 175 | O |
| ATOM | 1698 | CB | TYR | A | 287 | 3.395 | 88.955 | 50.828 | 1.00 | 21.17 | | C |
| ANISOU | 1698 | CB | TYR | A | 287 | 2679 | 2917 | 2447 | −409 | 216 | 291 | C |
| ATOM | 1699 | CG | TYR | A | 287 | 3.778 | 87.877 | 49.829 | 1.00 | 29.65 | | C |
| ANISOU | 1699 | CG | TYR | A | 287 | 3747 | 3990 | 3530 | −357 | 112 | 331 | C |
| ATOM | 1700 | CD1 | TYR | A | 287 | 4.292 | 86.643 | 50.243 | 1.00 | 29.68 | | C |
| ANISOU | 1700 | CD1 | TYR | A | 287 | 3912 | 3942 | 3422 | −373 | 117 | 395 | C |
| ATOM | 1701 | CD2 | TYR | A | 287 | 3.614 | 88.094 | 48.474 | 1.00 | 24.08 | | C |
| ANISOU | 1701 | CD2 | TYR | A | 287 | 2904 | 3317 | 2928 | −282 | 3 | 302 | C |
| ATOM | 1702 | CE1 | TYR | A | 287 | 4.634 | 85.664 | 49.323 | 1.00 | 20.77 | | C |
| ANISOU | 1702 | CE1 | TYR | A | 287 | 2780 | 2809 | 2303 | −320 | 24 | 427 | C |
| ATOM | 1703 | CE2 | TYR | A | 287 | 3.954 | 87.134 | 47.555 | 1.00 | 25.21 | | C |
| ANISOU | 1703 | CE2 | TYR | A | 287 | 3068 | 3446 | 3065 | −226 | −85 | 337 | C |
| ATOM | 1704 | CZ | TYR | A | 287 | 4.468 | 85.922 | 47.980 | 1.00 | 26.92 | | C |
| ANISOU | 1704 | CZ | TYR | A | 287 | 3417 | 3625 | 3185 | −247 | −70 | 399 | C |
| ATOM | 1705 | OH | TYR | A | 287 | 4.786 | 84.985 | 47.028 | 1.00 | 22.42 | | O |
| ANISOU | 1705 | OH | TYR | A | 287 | 2867 | 3039 | 2613 | −186 | −157 | 428 | O |
| ATOM | 1706 | N | TYR | A | 288 | 1.621 | 89.352 | 54.047 | 1.00 | 28.44 | | N |
| ANISOU | 1706 | N | TYR | A | 288 | 3879 | 3638 | 3288 | −664 | 747 | 183 | N |
| ATOM | 1707 | CA | TYR | A | 288 | 1.327 | 90.352 | 55.055 | 1.00 | 29.24 | | C |
| ANISOU | 1707 | CA | TYR | A | 288 | 4057 | 3713 | 3340 | −700 | 876 | 146 | C |
| ATOM | 1708 | C | TYR | A | 288 | 2.350 | 90.312 | 56.176 | 1.00 | 29.95 | | C |
| ANISOU | 1708 | C | TYR | A | 288 | 4470 | 3755 | 3156 | −679 | 835 | 236 | C |
| ATOM | 1709 | O | TYR | A | 288 | 2.709 | 89.245 | 56.637 | 1.00 | 32.55 | | O |
| ANISOU | 1709 | O | TYR | A | 288 | 5024 | 3999 | 3343 | −697 | 853 | 293 | O |
| ATOM | 1710 | CB | TYR | A | 288 | −0.060 | 90.122 | 55.650 | 1.00 | 31.71 | | C |
| ANISOU | 1710 | CB | TYR | A | 288 | 4352 | 3912 | 3783 | −826 | 1182 | 43 | C |
| ATOM | 1711 | CG | TYR | A | 288 | −1.212 | 90.507 | 54.763 | 1.00 | 34.72 | | C |
| ANISOU | 1711 | CG | TYR | A | 288 | 4392 | 4317 | 4481 | −840 | 1214 | −90 | C |
| ATOM | 1712 | CD2 | TYR | A | 288 | −1.770 | 91.776 | 54.837 | 1.00 | 34.99 | | C |
| ANISOU | 1712 | CD2 | TYR | A | 288 | 4277 | 4382 | 4635 | −827 | 1249 | −179 | C |
| ATOM | 1713 | CD1 | TYR | A | 288 | −1.764 | 89.596 | 53.868 | 1.00 | 35.28 | | C |
| ANISOU | 1713 | CD1 | TYR | A | 288 | 4298 | 4365 | 4743 | −859 | 1188 | −138 | C |
| ATOM | 1714 | CE2 | TYR | A | 288 | −2.837 | 92.133 | 54.037 | 1.00 | 36.60 | | C |
| ANISOU | 1714 | CE2 | TYR | A | 288 | 4172 | 4589 | 5147 | −823 | 1242 | −319 | C |
| ATOM | 1715 | CE1 | TYR | A | 288 | −2.830 | 89.946 | 53.059 | 1.00 | 34.47 | | C |
| ANISOU | 1715 | CE1 | TYR | A | 288 | 3887 | 4259 | 4950 | −856 | 1170 | −280 | C |
| ATOM | 1716 | CZ | TYR | A | 288 | −3.357 | 91.215 | 53.151 | 1.00 | 36.95 | | C |
| ANISOU | 1716 | CZ | TYR | A | 288 | 4056 | 4600 | 5385 | −834 | 1190 | −373 | C |
| ATOM | 1717 | OH | TYR | A | 288 | −4.412 | 91.577 | 52.357 | 1.00 | 38.82 | | O |
| ANISOU | 1717 | OH | TYR | A | 288 | 3992 | 4815 | 5941 | −813 | 1135 | −530 | O |
| ATOM | 1718 | N | ILE | A | 289 | 2.798 | 91.472 | 56.638 | 1.00 | 29.93 | | N |
| ANISOU | 1718 | N | ILE | A | 289 | 4505 | 3788 | 3079 | −634 | 764 | 240 | N |
| ATOM | 1719 | CA | ILE | A | 289 | 3.567 | 91.531 | 57.876 | 1.00 | 29.74 | | C |
| ANISOU | 1719 | CA | ILE | A | 289 | 4815 | 3679 | 2805 | −615 | 730 | 295 | C |
| ATOM | 1720 | C | ILE | A | 289 | 2.950 | 92.526 | 58.866 | 1.00 | 35.12 | | C |
| ANISOU | 1720 | C | ILE | A | 289 | 5607 | 4302 | 3435 | −658 | 902 | 238 | C |
| ATOM | 1721 | O | ILE | A | 289 | 2.153 | 93.380 | 58.487 | 1.00 | 33.19 | | O |
| ANISOU | 1721 | O | ILE | A | 289 | 5130 | 4116 | 3366 | −680 | 992 | 159 | O |
| ATOM | 1722 | CB | ILE | A | 289 | 5.029 | 91.918 | 57.616 | 1.00 | 29.25 | | C |
| ANISOU | 1722 | CB | ILE | A | 289 | 4746 | 3689 | 2679 | −500 | 421 | 360 | C |
| ATOM | 1723 | CG1 | ILE | A | 289 | 5.123 | 93.316 | 56.997 | 1.00 | 24.00 | | C |
| ANISOU | 1723 | CG1 | ILE | A | 289 | 3831 | 3141 | 2148 | −457 | 332 | 326 | C |
| ATOM | 1724 | CG2 | ILE | A | 289 | 5.691 | 90.876 | 56.724 | 1.00 | 24.37 | | C |
| ANISOU | 1724 | CG2 | ILE | A | 289 | 4050 | 3109 | 2102 | −454 | 277 | 414 | C |
| ATOM | 1725 | CD1 | ILE | A | 289 | 6.552 | 93.849 | 56.913 | 1.00 | 23.31 | | C |
| ANISOU | 1725 | CD1 | ILE | A | 289 | 3738 | 3095 | 2024 | −362 | 70 | 374 | C |
| ATOM | 1726 | N | LYS | A | 290 | 3.323 | 92.426 | 60.136 | 1.00 | 40.10 | | N |
| ANISOU | 1726 | N | LYS | A | 290 | 6614 | 4803 | 3819 | −659 | 936 | 271 | N |
| ATOM | 1727 | CA | LYS | A | 290 | 2.801 | 93.353 | 61.133 | 1.00 | 41.30 | | C |
| ANISOU | 1727 | CA | LYS | A | 290 | 6924 | 4880 | 3889 | −690 | 1106 | 220 | C |
| ATOM | 1728 | C | LYS | A | 290 | 3.791 | 94.466 | 61.359 | 1.00 | 40.95 | | C |
| ANISOU | 1728 | C | LYS | A | 290 | 6909 | 4888 | 3761 | −590 | 843 | 242 | C |
| ATOM | 1729 | O | LYS | A | 290 | 4.992 | 94.224 | 61.463 | 1.00 | 43.98 | | O |
| ANISOU | 1729 | O | LYS | A | 290 | 7416 | 5264 | 4030 | −507 | 574 | 304 | O |
| ATOM | 1730 | CB | LYS | A | 290 | 2.521 | 92.686 | 62.480 | 1.00 | 53.02 | | C |
| ANISOU | 1730 | CB | LYS | A | 290 | 8871 | 6150 | 5122 | −749 | 1331 | 234 | C |
| ATOM | 1731 | CG | LYS | A | 290 | 1.212 | 93.117 | 63.142 | 1.00 | 67.61 | | C |
| ANISOU | 1731 | CG | LYS | A | 290 | 10774 | 7900 | 7017 | −854 | 1726 | 145 | C |
| ATOM | 1732 | CD | LYS | A | 290 | 0.563 | 91.998 | 63.972 | 1.00 | 82.00 | | C |
| ANISOU | 1732 | CD | LYS | A | 290 | 12913 | 9510 | 8732 | −951 | 2040 | 139 | C |
| ATOM | 1733 | CE | LYS | A | 290 | 0.153 | 90.798 | 63.132 | 1.00 | 83.22 | | C |
| ANISOU | 1733 | CE | LYS | A | 290 | 12874 | 9685 | 9060 | −1024 | 2121 | 141 | C |
| ATOM | 1734 | NZ | LYS | A | 290 | −0.998 | 91.117 | 62.250 | 1.00 | 86.00 | | N |
| ANISOU | 1734 | NZ | LYS | A | 290 | 12767 | 10129 | 9782 | −1104 | 2304 | 32 | N |
| ATOM | 1735 | N | VAL | A | 291 | 3.274 | 95.690 | 61.406 | 1.00 | 38.75 | | N |
| ANISOU | 1735 | N | VAL | A | 291 | 6496 | 4656 | 3570 | −597 | 916 | 178 | N |
| ATOM | 1736 | CA | VAL | A | 291 | 4.058 | 96.857 | 61.766 | 1.00 | 30.64 | | C |
| ANISOU | 1736 | CA | VAL | A | 291 | 5520 | 3654 | 2466 | −519 | 709 | 184 | C |
| ATOM | 1737 | C | VAL | A | 291 | 3.534 | 97.396 | 63.077 | 1.00 | 37.63 | | C |
| ANISOU | 1737 | C | VAL | A | 291 | 6722 | 4400 | 3175 | −547 | 901 | 144 | C |
| ATOM | 1738 | O | VAL | A | 291 | 2.350 | 97.720 | 63.195 | 1.00 | 37.28 | | O |
| ANISOU | 1738 | O | VAL | A | 291 | 6600 | 4336 | 3227 | −621 | 1192 | 68 | O |
| ATOM | 1739 | CB | VAL | A | 291 | 3.997 | 97.956 | 60.707 | 1.00 | 37.86 | | C |
| ANISOU | 1739 | CB | VAL | A | 291 | 6048 | 4730 | 3608 | −489 | 609 | 147 | C |
| ATOM | 1740 | CG1 | VAL | A | 291 | 4.725 | 99.184 | 61.201 | 1.00 | 35.74 | | C |
| ANISOU | 1740 | CG1 | VAL | A | 291 | 5854 | 4462 | 3262 | −425 | 430 | 146 | C |
| ATOM | 1741 | CG2 | VAL | A | 291 | 4.582 | 97.459 | 59.391 | 1.00 | 37.47 | | C |
| ANISOU | 1741 | CG2 | VAL | A | 291 | 5736 | 4796 | 3705 | −451 | 431 | 191 | C |
| ATOM | 1742 | N | ARG | A | 292 | 4.421 | 97.498 | 64.062 | 1.00 | 44.44 | | N |
| ANISOU | 1742 | N | ARG | A | 292 | 7946 | 5149 | 3790 | −482 | 730 | 182 | N |
| ATOM | 1743 | CA | ARG | A | 292 | 4.045 | 97.907 | 65.412 | 1.00 | 47.71 | | C |
| ANISOU | 1743 | CA | ARG | A | 292 | 8766 | 5392 | 3971 | −492 | 896 | 153 | C |
| ATOM | 1744 | C | ARG | A | 292 | 4.053 | 99.424 | 65.616 | 1.00 | 52.29 | | C |
| ANISOU | 1744 | C | ARG | A | 292 | 9270 | 6017 | 4583 | −452 | 828 | 103 | C |
| ATOM | 1745 | O | ARG | A | 292 | 3.213 | 99.963 | 66.331 | 1.00 | 54.59 | | O |
| ANISOU | 1745 | O | ARG | A | 292 | 9714 | 6221 | 4805 | −492 | 1088 | 47 | O |
| ATOM | 1746 | CB | ARG | A | 292 | 4.979 | 97.250 | 66.425 | 1.00 | 52.28 | | C |
| ANISOU | 1746 | CB | ARG | A | 292 | 9839 | 5788 | 4238 | −421 | 710 | 211 | C |
| ATOM | 1747 | CG | ARG | A | 292 | 4.846 | 95.739 | 66.502 | 1.00 | 60.96 | | C |
| ANISOU | 1747 | CG | ARG | A | 292 | 11090 | 6788 | 5282 | −459 | 814 | 250 | C |
| ATOM | 1748 | CD | ARG | A | 292 | 3.578 | 95.360 | 67.238 | 1.00 | 67.92 | | C |
| ANISOU | 1748 | CD | ARG | A | 292 | 12125 | 7514 | 6166 | −556 | 1231 | 198 | C |
| ATOM | 1749 | NE | ARG | A | 292 | 3.338 | 93.926 | 67.206 | 1.00 | 73.38 | | N |
| ANISOU | 1749 | NE | ARG | A | 292 | 12893 | 8118 | 6870 | −604 | 1345 | 219 | N |
| ATOM | 1750 | CZ | ARG | A | 292 | 3.977 | 93.048 | 67.969 | 1.00 | 82.14 | | C |
| ANISOU | 1750 | CZ | ARG | A | 292 | 14344 | 9047 | 7818 | −541 | 1200 | 246 | C |
| ATOM | 1751 | NH1 | ARG | A | 292 | 4.899 | 93.464 | 68.830 | 1.00 | 83.94 | | N |
| ANISOU | 1751 | NH1 | ARG | A | 292 | 14855 | 9159 | 7881 | −423 | 925 | 250 | N |
| ATOM | 1752 | NH2 | ARG | A | 292 | 3.695 | 91.754 | 67.867 | 1.00 | 83.86 | | N |
| ANISOU | 1752 | NH2 | ARG | A | 292 | 14619 | 9192 | 8053 | −592 | 1321 | 259 | N |
| ATOM | 1753 | N | GLY | A | 293 | 5.009 | 100.110 | 64.999 | 1.00 | 54.11 | | N |
| ANISOU | 1753 | N | GLY | A | 293 | 9269 | 6369 | 4923 | −377 | 498 | 120 | N |
| ATOM | 1754 | CA | GLY | A | 293 | 5.147 | 101.542 | 65.188 | 1.00 | 52.67 | | C |
| ANISOU | 1754 | CA | GLY | A | 293 | 9029 | 6219 | 4766 | −336 | 400 | 78 | C |
| ATOM | 1755 | C | GLY | A | 293 | 5.710 | 102.255 | 63.972 | 1.00 | 49.25 | | C |
| ANISOU | 1755 | C | GLY | A | 293 | 8166 | 5965 | 4582 | −303 | 181 | 81 | C |
| ATOM | 1756 | O | GLY | A | 293 | 6.315 | 101.637 | 63.094 | 1.00 | 41.61 | | O |
| ANISOU | 1756 | O | GLY | A | 293 | 6999 | 5079 | 3732 | −289 | 39 | 126 | O |
| ATOM | 1757 | N | LEU | A | 294 | 5.496 | 103.563 | 63.915 | 1.00 | 49.70 | | N |
| ANISOU | 1757 | N | LEU | A | 294 | 8102 | 6070 | 4712 | −291 | 171 | 33 | N |
| ATOM | 1758 | CA | LEU | A | 294 | 6.065 | 104.378 | 62.852 | 1.00 | 44.87 | | C |
| ANISOU | 1758 | CA | LEU | A | 294 | 7145 | 5595 | 4307 | −260 | −22 | 36 | C |
| ATOM | 1759 | C | LEU | A | 294 | 6.482 | 105.726 | 63.445 | 1.00 | 53.36 | | C |
| ANISOU | 1759 | C | LEU | A | 294 | 8310 | 6631 | 5334 | −216 | −165 | 3 | C |
| ATOM | 1760 | O | LEU | A | 294 | 5.641 | 106.573 | 63.750 | 1.00 | 57.98 | | O |
| ANISOU | 1760 | O | LEU | A | 294 | 8912 | 7209 | 5910 | −231 | −9 | −55 | O |
| ATOM | 1761 | CB | LEU | A | 294 | 5.060 | 104.542 | 61.716 | 1.00 | 40.96 | | C |
| ANISOU | 1761 | CB | LEU | A | 294 | 6312 | 5224 | 4025 | −303 | 153 | 1 | C |
| ATOM | 1762 | CG | LEU | A | 294 | 5.611 | 104.738 | 60.301 | 1.00 | 46.98 | | C |
| ANISOU | 1762 | CG | LEU | A | 294 | 6749 | 6114 | 4987 | −279 | −4 | 30 | C |
| ATOM | 1763 | CD1 | LEU | A | 294 | 4.474 | 104.715 | 59.305 | 1.00 | 47.02 | | C |
| ANISOU | 1763 | CD1 | LEU | A | 294 | 6505 | 6198 | 5163 | −307 | 159 | −17 | C |
| ATOM | 1764 | CD2 | LEU | A | 294 | 6.372 | 106.032 | 60.172 | 1.00 | 51.85 | | C |
| ANISOU | 1764 | CD2 | LEU | A | 294 | 7297 | 6753 | 5652 | −237 | −191 | 25 | C |
| ATOM | 1765 | N | ASP | A | 295 | 7.789 | 105.918 | 63.599 | 1.00 | 48.37 | | N |
| ANISOU | 1765 | N | ASP | A | 295 | 7720 | 5964 | 4694 | −158 | −468 | 29 | N |
| ATOM | 1766 | CA | ASP | A | 295 | 8.315 | 107.093 | 64.275 | 1.00 | 42.91 | | C |
| ANISOU | 1766 | CA | ASP | A | 295 | 7147 | 5204 | 3953 | −112 | −645 | −7 | C |
| ATOM | 1767 | C | ASP | A | 295 | 8.841 | 108.144 | 63.316 | 1.00 | 35.49 | | C |
| ANISOU | 1767 | C | ASP | A | 295 | 5875 | 4368 | 3243 | −108 | −777 | −16 | C |
| ATOM | 1768 | O | ASP | A | 295 | 9.341 | 107.834 | 62.241 | 1.00 | 34.32 | | O |
| ANISOU | 1768 | O | ASP | A | 295 | 5458 | 4307 | 3273 | −118 | −833 | 18 | O |
| ATOM | 1769 | CB | ASP | A | 295 | 9.440 | 106.708 | 65.243 | 1.00 | 54.98 | | C |
| ANISOU | 1769 | CB | ASP | A | 295 | 8975 | 6579 | 5336 | −41 | −929 | 0 | C |
| ATOM | 1770 | CG | ASP | A | 295 | 8.990 | 105.739 | 66.329 | 1.00 | 66.82 | | C |
| ANISOU | 1770 | CG | ASP | A | 295 | 10907 | 7929 | 6552 | −33 | −811 | 11 | C |
| ATOM | 1771 | OD1 | ASP | A | 295 | 7.783 | 105.419 | 66.401 | 1.00 | 72.06 | | O |
| ANISOU | 1771 | OD1 | ASP | A | 295 | 11628 | 8605 | 7146 | −97 | −473 | 8 | O |
| ATOM | 1772 | OD2 | ASP | A | 295 | 9.854 | 105.300 | 67.121 | 1.00 | 69.13 | | O |
| ANISOU | 1772 | OD2 | ASP | A | 295 | 11494 | 8072 | 6699 | 39 | −1061 | 14 | O |
| ATOM | 1773 | N | MET | A | 296 | 8.703 | 109.399 | 63.718 | 1.00 | 34.78 | | N |
| ANISOU | 1773 | N | MET | A | 296 | 5829 | 4250 | 3134 | −94 | −807 | −62 | N |
| ATOM | 1774 | CA | MET | A | 296 | 9.372 | 110.499 | 63.057 | 1.00 | 27.54 | | C |
| ANISOU | 1774 | CA | MET | A | 296 | 4679 | 3382 | 2405 | −87 | −962 | −73 | C |
| ATOM | 1775 | C | MET | A | 296 | 9.836 | 111.459 | 64.145 | 1.00 | 31.15 | | C |
| ANISOU | 1775 | C | MET | A | 296 | 5359 | 3716 | 2761 | −44 | −1144 | −121 | C |
| ATOM | 1776 | O | MET | A | 296 | 9.051 | 111.792 | 65.033 | 1.00 | 34.65 | | O |
| ANISOU | 1776 | O | MET | A | 296 | 6052 | 4094 | 3020 | −33 | −1026 | −156 | O |
| ATOM | 1777 | CB | MET | A | 296 | 8.443 | 111.191 | 62.063 | 1.00 | 37.62 | | C |
| ANISOU | 1777 | CB | MET | A | 296 | 5714 | 4777 | 3804 | −122 | −773 | −89 | C |
| ATOM | 1778 | CG | MET | A | 296 | 9.138 | 112.241 | 61.200 | 1.00 | 40.85 | | C |
| ANISOU | 1778 | CG | MET | A | 296 | 5893 | 5225 | 4401 | −122 | −900 | −88 | C |
| ATOM | 1779 | SD | MET | A | 296 | 8.055 | 112.926 | 59.938 | 1.00 | 35.30 | | S |
| ANISOU | 1779 | SD | MET | A | 296 | 4962 | 4632 | 3817 | −140 | −713 | −106 | S |
| ATOM | 1780 | CE | MET | A | 296 | 6.502 | 112.669 | 60.751 | 1.00 | 79.08 | | C |
| ANISOU | 1780 | CE | MET | A | 296 | 10663 | 10167 | 9216 | −141 | −482 | −164 | C |
| ATOM | 1781 | N | PHE | A | 297 | 11.109 | 111.868 | 64.097 | 1.00 | 29.36 | | N |
| ANISOU | 1781 | N | PHE | A | 297 | 5049 | 3439 | 2667 | −18 | −1426 | −130 | N |
| ATOM | 1782 | CA | PHE | A | 297 | 11.712 | 112.729 | 65.122 | 1.00 | 30.97 | | C |
| ANISOU | 1782 | CA | PHE | A | 297 | 5459 | 3502 | 2804 | 33 | −1665 | −186 | C |
| ATOM | 1783 | C | PHE | A | 297 | 11.467 | 112.254 | 66.538 | 1.00 | 34.63 | | C |
| ANISOU | 1783 | C | PHE | A | 297 | 6377 | 3814 | 2967 | 90 | −1706 | −205 | C |
| ATOM | 1784 | O | PHE | A | 297 | 11.275 | 113.070 | 67.440 | 1.00 | 42.03 | | O |
| ANISOU | 1784 | O | PHE | A | 297 | 7564 | 4648 | 3756 | 127 | −1758 | −252 | O |
| ATOM | 1785 | CB | PHE | A | 297 | 11.190 | 114.167 | 65.002 | 1.00 | 36.09 | | C |
| ANISOU | 1785 | CB | PHE | A | 297 | 6043 | 4183 | 3486 | 14 | −1588 | −222 | C |
| ATOM | 1786 | CG | PHE | A | 297 | 11.523 | 114.821 | 63.699 | 1.00 | 34.67 | | C |
| ANISOU | 1786 | CG | PHE | A | 297 | 5491 | 4107 | 3575 | −33 | −1573 | −207 | C |
| ATOM | 1787 | CD1 | PHE | A | 297 | 12.817 | 114.770 | 63.192 | 1.00 | 33.59 | | C |
| ANISOU | 1787 | CD1 | PHE | A | 297 | 5150 | 3944 | 3667 | −43 | −1769 | −204 | C |
| ATOM | 1788 | CD2 | PHE | A | 297 | 10.539 | 115.482 | 62.970 | 1.00 | 32.57 | | C |
| ANISOU | 1788 | CD2 | PHE | A | 297 | 5092 | 3943 | 3338 | −65 | −1354 | −206 | C |
| ATOM | 1789 | CE1 | PHE | A | 297 | 13.122 | 115.372 | 61.973 | 1.00 | 33.84 | | C |
| ANISOU | 1789 | CE1 | PHE | A | 297 | 4881 | 4045 | 3932 | −94 | −1706 | −187 | C |
| ATOM | 1790 | CE2 | PHE | A | 297 | 10.830 | 116.087 | 61.762 | 1.00 | 28.26 | | C |
| ANISOU | 1790 | CE2 | PHE | A | 297 | 4271 | 3464 | 3002 | −101 | −1335 | −190 | C |
| ATOM | 1791 | CZ | PHE | A | 297 | 12.125 | 116.035 | 61.258 | 1.00 | 33.17 | | C |
| ANISOU | 1791 | CZ | PHE | A | 297 | 4720 | 4053 | 3828 | −121 | −1491 | −174 | C |
| ATOM | 1792 | N | GLY | A | 298 | 11.435 | 110.942 | 66.739 | 1.00 | 35.68 | | N |
| ANISOU | 1792 | N | GLY | A | 298 | 6652 | 3918 | 2988 | 101 | −1668 | −169 | N |
| ATOM | 1793 | CA | GLY | A | 298 | 11.313 | 110.402 | 68.080 | 1.00 | 39.40 | | C |
| ANISOU | 1793 | CA | GLY | A | 298 | 7614 | 4208 | 3149 | 162 | −1715 | −182 | C |
| ATOM | 1794 | C | GLY | A | 298 | 9.887 | 110.325 | 68.599 | 1.00 | 54.08 | | C |
| ANISOU | 1794 | C | GLY | A | 298 | 9721 | 6054 | 4775 | 127 | −1341 | −179 | C |
| ATOM | 1795 | O | GLY | A | 298 | 9.670 | 109.943 | 69.748 | 1.00 | 69.14 | | O |
| ANISOU | 1795 | O | GLY | A | 298 | 12091 | 7788 | 6391 | 171 | −1316 | −189 | O |
| ATOM | 1796 | N | THR | A | 299 | 8.918 | 110.719 | 67.776 | 1.00 | 47.82 | | N |
| ANISOU | 1796 | N | THR | A | 299 | 8636 | 5420 | 4115 | 54 | −1052 | −177 | N |
| ATOM | 1797 | CA | THR | A | 299 | 7.507 | 110.621 | 68.145 | 1.00 | 49.70 | | C |
| ANISOU | 1797 | CA | THR | A | 299 | 9022 | 5648 | 4213 | 10 | −667 | −195 | C |
| ATOM | 1798 | C | THR | A | 299 | 6.865 | 109.401 | 67.493 | 1.00 | 52.15 | | C |
| ANISOU | 1798 | C | THR | A | 299 | 9185 | 6043 | 4586 | −56 | −420 | −156 | C |
| ATOM | 1799 | O | THR | A | 299 | 6.926 | 109.261 | 66.260 | 1.00 | 46.16 | | O |
| ANISOU | 1799 | O | THR | A | 299 | 8029 | 5444 | 4066 | −91 | −426 | −132 | O |
| ATOM | 1800 | CB | THR | A | 299 | 6.715 | 111.865 | 67.705 | 1.00 | 55.70 | | C |
| ANISOU | 1800 | CB | THR | A | 299 | 9553 | 6506 | 5103 | −16 | −514 | −246 | C |
| ATOM | 1801 | OG1 | THR | A | 299 | 7.490 | 113.047 | 67.944 | 1.00 | 61.89 | | O |
| ANISOU | 1801 | OG1 | THR | A | 299 | 10353 | 7250 | 5913 | 34 | −788 | −275 | O |
| ATOM | 1802 | CG2 | THR | A | 299 | 5.393 | 111.950 | 68.454 | 1.00 | 57.53 | | C |
| ANISOU | 1802 | CG2 | THR | A | 299 | 10014 | 6665 | 5179 | −39 | −154 | −297 | C |
| ATOM | 1803 | N | ASN | A | 300 | 6.245 | 108.530 | 68.295 | 1.00 | 54.04 | | N |
| ANISOU | 1803 | N | ASN | A | 300 | 9760 | 6163 | 4610 | −73 | −196 | −151 | N |
| ATOM | 1804 | CA | ASN | A | 300 | 5.495 | 107.391 | 67.742 | 1.00 | 53.87 | | C |
| ANISOU | 1804 | CA | ASN | A | 300 | 9606 | 6203 | 4658 | −148 | 74 | −126 | C |
| ATOM | 1805 | C | ASN | A | 300 | 4.114 | 107.851 | 67.276 | 1.00 | 46.94 | | C |
| ANISOU | 1805 | C | ASN | A | 300 | 8481 | 5415 | 3939 | −216 | 419 | −188 | C |
| ATOM | 1806 | O | ASN | A | 300 | 3.308 | 108.330 | 68.078 | 1.00 | 46.80 | | O |
| ANISOU | 1806 | O | ASN | A | 300 | 8671 | 5300 | 3810 | −227 | 654 | −248 | O |
| ATOM | 1807 | CB | ASN | A | 300 | 5.375 | 106.253 | 68.766 | 1.00 | 59.27 | | C |
| ANISOU | 1807 | CB | ASN | A | 300 | 10757 | 6701 | 5063 | −150 | 200 | −100 | C |
| ATOM | 1808 | CG | ASN | A | 300 | 4.783 | 104.959 | 68.169 | 1.00 | 58.72 | | C |
| ANISOU | 1808 | CG | ASN | A | 300 | 10549 | 6684 | 5080 | −230 | 436 | −68 | C |
| ATOM | 1809 | OD1 | ASN | A | 300 | 4.650 | 104.807 | 66.947 | 1.00 | 44.12 | | O |
| ANISOU | 1809 | OD1 | ASN | A | 300 | 8260 | 5010 | 3494 | −267 | 435 | −60 | O |
| ATOM | 1810 | ND2 | ASN | A | 300 | 4.433 | 104.020 | 69.048 | 1.00 | 65.32 | | N |
| ANISOU | 1810 | ND2 | ASN | A | 300 | 11796 | 7344 | 5679 | −254 | 636 | −52 | N |
| ATOM | 1811 | N | MET | A | 301 | 3.850 | 107.714 | 65.978 | 1.00 | 37.38 | | N |
| ANISOU | 1811 | N | MET | A | 301 | 6836 | 4374 | 2995 | −252 | 439 | −186 | N |
| ATOM | 1812 | CA | MET | A | 301 | 2.616 | 108.246 | 65.403 | 1.00 | 43.23 | | C |
| ANISOU | 1812 | CA | MET | A | 301 | 7296 | 5195 | 3933 | −294 | 683 | −264 | C |
| ATOM | 1813 | C | MET | A | 301 | 1.473 | 107.242 | 65.450 | 1.00 | 51.56 | | C |
| ANISOU | 1813 | C | MET | A | 301 | 8342 | 6211 | 5038 | −372 | 1036 | −301 | C |
| ATOM | 1814 | O | MET | A | 301 | 0.313 | 107.613 | 65.261 | 1.00 | 48.68 | | O |
| ANISOU | 1814 | O | MET | A | 301 | 7797 | 5862 | 4836 | −407 | 1280 | −396 | O |
| ATOM | 1815 | CB | MET | A | 301 | 2.825 | 108.679 | 63.959 | 1.00 | 37.43 | | C |
| ANISOU | 1815 | CB | MET | A | 301 | 6135 | 4631 | 3455 | −280 | 516 | −258 | C |
| ATOM | 1816 | CG | MET | A | 301 | 4.119 | 109.381 | 63.703 | 1.00 | 34.97 | | C |
| ANISOU | 1816 | CG | MET | A | 301 | 5790 | 4355 | 3143 | −224 | 179 | −208 | C |
| ATOM | 1817 | SD | MET | A | 301 | 3.918 | 111.138 | 63.740 | 1.00 | 65.05 | | S |
| ANISOU | 1817 | SD | MET | A | 301 | 9530 | 8179 | 7005 | −187 | 123 | −275 | S |
| ATOM | 1818 | CE | MET | A | 301 | 5.570 | 111.637 | 64.217 | 1.00 | 102.24 | | C |
| ANISOU | 1818 | CE | MET | A | 301 | 14399 | 12828 | 11618 | −135 | −241 | −222 | C |
| ATOM | 1819 | N | MET | A | 302 | 1.790 | 105.971 | 65.686 | 1.00 | 54.43 | | N |
| ANISOU | 1819 | N | MET | A | 302 | 8884 | 6513 | 5285 | −399 | 1060 | −238 | N |
| ATOM | 1820 | CA | MET | A | 302 | 0.739 | 104.968 | 65.745 | 1.00 | 52.84 | | C |
| ANISOU | 1820 | CA | MET | A | 302 | 8681 | 6256 | 5142 | −487 | 1408 | −273 | C |
| ATOM | 1821 | C | MET | A | 302 | −0.018 | 105.040 | 67.053 | 1.00 | 60.20 | | C |
| ANISOU | 1821 | C | MET | A | 302 | 9980 | 6999 | 5895 | −525 | 1749 | −328 | C |
| ATOM | 1822 | O | MET | A | 302 | 0.527 | 104.877 | 68.153 | 1.00 | 55.23 | | O |
| ANISOU | 1822 | O | MET | A | 302 | 9819 | 6213 | 4954 | −495 | 1721 | −282 | O |
| ATOM | 1823 | CB | MET | A | 302 | 1.294 | 103.573 | 65.499 | 1.00 | 50.87 | | C |
| ANISOU | 1823 | CB | MET | A | 302 | 8499 | 5997 | 4833 | −506 | 1331 | −187 | C |
| ATOM | 1824 | CG | MET | A | 302 | 1.714 | 103.412 | 64.054 | 1.00 | 49.66 | | C |
| ANISOU | 1824 | CG | MET | A | 302 | 7936 | 6024 | 4910 | −486 | 1103 | −155 | C |
| ATOM | 1825 | SD | MET | A | 302 | 2.107 | 101.735 | 63.541 | 1.00 | 70.67 | | S |
| ANISOU | 1825 | SD | MET | A | 302 | 10591 | 8691 | 7569 | −516 | 1062 | −75 | S |
| ATOM | 1826 | CE | MET | A | 302 | 0.618 | 100.882 | 64.041 | 1.00 | 51.27 | | C |
| ANISOU | 1826 | CE | MET | A | 302 | 8222 | 6110 | 5150 | −634 | 1530 | −146 | C |
| ATOM | 1827 | N | SER | A | 303 | −1.295 | 105.356 | 66.901 | 1.00 | 76.55 | | N |
| ANISOU | 1827 | N | SER | A | 303 | 11834 | 9071 | 8180 | −583 | 2066 | −440 | N |
| ATOM | 1828 | CA | SER | A | 303 | −2.198 | 105.572 | 68.015 | 1.00 | 90.63 | | C |
| ANISOU | 1828 | CA | SER | A | 303 | 13892 | 10678 | 9867 | −629 | 2462 | −521 | C |
| ATOM | 1829 | C | SER | A | 303 | −2.788 | 104.265 | 68.535 | 1.00 | 95.93 | | C |
| ANISOU | 1829 | C | SER | A | 303 | 14735 | 11187 | 10525 | −722 | 2770 | −510 | C |
| ATOM | 1830 | O | SER | A | 303 | −3.177 | 104.175 | 69.691 | 1.00 | 98.20 | | O |
| ANISOU | 1830 | O | SER | A | 303 | 15328 | 11267 | 10714 | −738 | 2950 | −509 | O |
| ATOM | 1831 | CB | SER | A | 303 | −3.321 | 106.521 | 67.574 | 1.00 | 94.74 | | C |
| ANISOU | 1831 | CB | SER | A | 303 | 14033 | 11261 | 10702 | −641 | 2638 | −665 | C |
| ATOM | 1832 | OG | SER | A | 303 | −3.808 | 107.306 | 68.644 | 1.00 | 99.43 | | O |
| ANISOU | 1832 | OG | SER | A | 303 | 14894 | 11716 | 11171 | −634 | 2883 | −736 | O |
| ATOM | 1833 | N | SER | A | 304 | −2.811 | 103.243 | 67.684 | 1.00 | 101.59 | | N |
| ANISOU | 1833 | N | SER | A | 304 | 15237 | 11983 | 11378 | −775 | 2766 | −487 | N |
| ATOM | 1834 | CA | SER | A | 304 | −3.476 | 101.974 | 68.013 | 1.00 | 106.26 | | C |
| ANISOU | 1834 | CA | SER | A | 304 | 15886 | 12425 | 12061 | −864 | 3001 | −485 | C |
| ATOM | 1835 | C | SER | A | 304 | −2.532 | 100.885 | 68.493 | 1.00 | 102.10 | | C |
| ANISOU | 1835 | C | SER | A | 304 | 15736 | 11799 | 11257 | −844 | 2841 | −356 | C |
| ATOM | 1836 | O | SER | A | 304 | −1.347 | 100.871 | 68.156 | 1.00 | 101.39 | | O |
| ANISOU | 1836 | O | SER | A | 304 | 15726 | 11810 | 10987 | −770 | 2508 | −266 | O |
| ATOM | 1837 | CB | SER | A | 304 | −4.279 | 101.442 | 66.818 | 1.00 | 108.65 | | C |
| ANISOU | 1837 | CB | SER | A | 304 | 15701 | 12841 | 12739 | −937 | 3110 | −564 | C |
| ATOM | 1838 | OG | SER | A | 304 | −5.160 | 102.425 | 66.300 | 1.00 | 111.49 | | O |
| ANISOU | 1838 | OG | SER | A | 304 | 15676 | 13282 | 13402 | −936 | 3205 | −703 | O |
| ATOM | 1839 | N | SER | A | 305 | −3.084 | 99.948 | 69.258 | 1.00 | 96.53 | | N |
| ANISOU | 1839 | N | SER | A | 305 | 15253 | 10882 | 10543 | −908 | 3075 | −360 | N |
| ATOM | 1840 | CA | SER | A | 305 | −2.257 | 99.049 | 70.036 | 1.00 | 94.87 | | C |
| ANISOU | 1840 | CA | SER | A | 305 | 15491 | 10511 | 10044 | −869 | 2941 | −259 | C |
| ATOM | 1841 | C | SER | A | 305 | −1.802 | 97.842 | 69.232 | 1.00 | 94.63 | | C |
| ANISOU | 1841 | C | SER | A | 305 | 15348 | 10565 | 10043 | −888 | 2808 | −198 | C |
| ATOM | 1842 | O | SER | A | 305 | −0.596 | 97.649 | 69.036 | 1.00 | 94.19 | | O |
| ANISOU | 1842 | O | SER | A | 305 | 15407 | 10577 | 9804 | −804 | 2463 | −107 | O |
| ATOM | 1843 | CB | SER | A | 305 | −3.033 | 98.562 | 71.261 | 1.00 | 92.83 | | C |
| ANISOU | 1843 | CB | SER | A | 305 | 15578 | 9953 | 9740 | −928 | 3269 | −295 | C |
| ATOM | 1844 | OG | SER | A | 305 | −3.674 | 99.625 | 71.945 | 1.00 | 91.34 | | O |
| ANISOU | 1844 | OG | SER | A | 305 | 15453 | 9675 | 9576 | −931 | 3460 | −362 | O |
| ATOM | 1845 | N | LYS | A | 306 | −2.751 | 97.047 | 68.748 | 1.00 | 93.46 | | N |
| ANISOU | 1845 | N | LYS | A | 306 | 14958 | 10405 | 10146 | −992 | 3059 | −257 | N |
| ATOM | 1846 | CA | LYS | A | 306 | −2.438 | 96.056 | 67.730 | 1.00 | 90.54 | | C |
| ANISOU | 1846 | CA | LYS | A | 306 | 14380 | 10158 | 9862 | −1013 | 2935 | −212 | C |
| ATOM | 1847 | C | LYS | A | 306 | −1.631 | 96.616 | 66.571 | 1.00 | 89.39 | | C |
| ANISOU | 1847 | C | LYS | A | 306 | 13952 | 10276 | 9739 | −953 | 2632 | −164 | C |
| ATOM | 1848 | O | LYS | A | 306 | −1.928 | 97.678 | 66.020 | 1.00 | 88.49 | | O |
| ANISOU | 1848 | O | LYS | A | 306 | 13549 | 10300 | 9774 | −946 | 2638 | −225 | O |
| ATOM | 1849 | CB | LYS | A | 306 | −3.702 | 95.373 | 67.202 | 1.00 | 86.75 | | C |
| ANISOU | 1849 | CB | LYS | A | 306 | 13583 | 9655 | 9724 | −1131 | 3230 | −311 | C |
| ATOM | 1850 | CG | LYS | A | 306 | −3.413 | 93.986 | 66.586 | 1.00 | 80.75 | | C |
| ANISOU | 1850 | CG | LYS | A | 306 | 12786 | 8915 | 8981 | −1160 | 3152 | −255 | C |
| ATOM | 1851 | CD | LYS | A | 306 | −2.141 | 93.366 | 67.186 | 1.00 | 74.93 | | C |
| ANISOU | 1851 | CD | LYS | A | 306 | 12492 | 8102 | 7878 | −1079 | 2904 | −126 | C |
| ATOM | 1852 | CE | LYS | A | 306 | −1.902 | 91.923 | 66.791 | 1.00 | 66.85 | | C |
| ANISOU | 1852 | CE | LYS | A | 306 | 11502 | 7052 | 6845 | −1105 | 2856 | −76 | C |
| ATOM | 1853 | NZ | LYS | A | 306 | −0.666 | 91.437 | 67.468 | 1.00 | 59.41 | | N |
| ANISOU | 1853 | NZ | LYS | A | 306 | 10990 | 6015 | 5569 | −1005 | 2586 | 25 | N |
| ATOM | 1854 | N | GLY | A | 307 | −0.568 | 95.895 | 66.253 | 1.00 | 89.09 | | N |
| ANISOU | 1854 | N | GLY | A | 307 | 14026 | 10284 | 9542 | −902 | 2360 | −58 | N |
| ATOM | 1855 | CA | GLY | A | 307 | 0.223 | 96.162 | 65.077 | 1.00 | 88.53 | | C |
| ANISOU | 1855 | CA | GLY | A | 307 | 13674 | 10433 | 9530 | −848 | 2057 | −8 | C |
| ATOM | 1856 | C | GLY | A | 307 | −0.682 | 96.166 | 63.860 | 1.00 | 82.77 | | C |
| ANISOU | 1856 | C | GLY | A | 307 | 12418 | 9842 | 9189 | −904 | 2147 | −89 | C |
| ATOM | 1857 | O | GLY | A | 307 | −1.687 | 95.451 | 63.792 | 1.00 | 89.46 | | O |
| ANISOU | 1857 | O | GLY | A | 307 | 13183 | 10614 | 10193 | −1012 | 2454 | −151 | O |
| ATOM | 1858 | N | LEU | A | 308 | −0.311 | 96.990 | 62.897 | 1.00 | 65.97 | | N |
| ANISOU | 1858 | N | LEU | A | 308 | 9947 | 7897 | 7221 | −827 | 1868 | −96 | N |
| ATOM | 1859 | CA | LEU | A | 308 | −1.004 | 97.092 | 61.633 | 1.00 | 45.76 | | C |
| ANISOU | 1859 | CA | LEU | A | 308 | 6920 | 5464 | 5002 | −841 | 1855 | −170 | C |
| ATOM | 1860 | C | LEU | A | 308 | −0.583 | 95.944 | 60.706 | 1.00 | 42.50 | | C |
| ANISOU | 1860 | C | LEU | A | 308 | 6391 | 5110 | 4647 | −834 | 1699 | −107 | C |
| ATOM | 1861 | O | LEU | A | 308 | 0.602 | 95.721 | 60.497 | 1.00 | 43.21 | | O |
| ANISOU | 1861 | O | LEU | A | 308 | 6573 | 5253 | 4590 | −760 | 1425 | −6 | O |
| ATOM | 1862 | CB | LEU | A | 308 | −0.670 | 98.443 | 61.010 | 1.00 | 42.87 | | C |
| ANISOU | 1862 | CB | LEU | A | 308 | 6321 | 5241 | 4727 | −749 | 1612 | −190 | C |
| ATOM | 1863 | CG | LEU | A | 308 | −1.629 | 99.264 | 60.171 | 1.00 | 45.54 | | C |
| ANISOU | 1863 | CG | LEU | A | 308 | 6273 | 5657 | 5372 | −742 | 1641 | −312 | C |
| ATOM | 1864 | CD1 | LEU | A | 308 | −2.993 | 99.384 | 60.832 | 1.00 | 45.75 | | C |
| ANISOU | 1864 | CD1 | LEU | A | 308 | 6273 | 5566 | 5545 | −831 | 2016 | −446 | C |
| ATOM | 1865 | CD2 | LEU | A | 308 | −0.994 | 100.617 | 60.018 | 1.00 | 47.73 | | C |
| ANISOU | 1865 | CD2 | LEU | A | 308 | 6512 | 6024 | 5598 | −650 | 1410 | −295 | C |
| ATOM | 1866 | N | GLU | A | 309 | −1.541 | 95.212 | 60.152 | 1.00 | 42.22 | | N |
| ANISOU | 1866 | N | GLU | A | 309 | 6145 | 5053 | 4844 | −910 | 1869 | −177 | N |
| ATOM | 1867 | CA | GLU | A | 309 | −1.207 | 94.127 | 59.228 | 1.00 | 41.59 | | C |
| ANISOU | 1867 | CA | GLU | A | 309 | 5955 | 5022 | 4824 | −900 | 1721 | −125 | C |
| ATOM | 1868 | C | GLU | A | 309 | −1.169 | 94.638 | 57.803 | 1.00 | 37.63 | | C |
| ANISOU | 1868 | C | GLU | A | 309 | 5083 | 4674 | 4539 | −821 | 1472 | −156 | C |
| ATOM | 1869 | O | GLU | A | 309 | −2.205 | 94.911 | 57.205 | 1.00 | 40.57 | | O |
| ANISOU | 1869 | O | GLU | A | 309 | 5171 | 5056 | 5186 | −842 | 1544 | −275 | O |
| ATOM | 1870 | CB | GLU | A | 309 | −2.206 | 92.970 | 59.324 | 1.00 | 42.63 | | C |
| ANISOU | 1870 | CB | GLU | A | 309 | 6072 | 5031 | 5095 | −1022 | 2010 | −185 | C |
| ATOM | 1871 | CG | GLU | A | 309 | −1.582 | 91.631 | 58.999 | 1.00 | 58.19 | | C |
| ANISOU | 1871 | CG | GLU | A | 309 | 8159 | 6987 | 6963 | −1022 | 1901 | −89 | C |
| ATOM | 1872 | CD | GLU | A | 309 | −2.331 | 90.458 | 59.609 | 1.00 | 79.13 | | C |
| ANISOU | 1872 | CD | GLU | A | 309 | 10978 | 9461 | 9627 | −1157 | 2233 | −115 | C |
| ATOM | 1873 | OE1 | GLU | A | 309 | −2.719 | 90.549 | 60.794 | 1.00 | 88.97 | | O |
| ANISOU | 1873 | OE1 | GLU | A | 309 | 12500 | 10556 | 10746 | −1232 | 2529 | −134 | O |
| ATOM | 1874 | OE2 | GLU | A | 309 | −2.545 | 89.447 | 58.896 | 1.00 | 80.27 | | O |
| ANISOU | 1874 | OE2 | GLU | A | 309 | 10992 | 9600 | 9905 | −1190 | 2211 | −119 | O |
| ATOM | 1875 | N | MET | A | 310 | 0.033 | 94.732 | 57.251 | 1.00 | 37.78 | | N |
| ANISOU | 1875 | N | MET | A | 310 | 5120 | 4792 | 4441 | −725 | 1178 | −55 | N |
| ATOM | 1876 | CA | MET | A | 310 | 0.248 | 95.435 | 55.993 | 1.00 | 28.38 | | C |
| ANISOU | 1876 | CA | MET | A | 310 | 3663 | 3729 | 3392 | −637 | 949 | −68 | C |
| ATOM | 1877 | C | MET | A | 310 | 0.681 | 94.514 | 54.865 | 1.00 | 30.36 | | C |
| ANISOU | 1877 | C | MET | A | 310 | 3818 | 4027 | 3689 | −597 | 788 | −17 | C |
| ATOM | 1878 | O | MET | A | 310 | 1.585 | 93.690 | 55.030 | 1.00 | 31.85 | | O |
| ANISOU | 1878 | O | MET | A | 310 | 4173 | 4206 | 3723 | −585 | 714 | 81 | O |
| ATOM | 1879 | CB | MET | A | 310 | 1.295 | 96.517 | 56.184 | 1.00 | 24.35 | | C |
| ANISOU | 1879 | CB | MET | A | 310 | 3229 | 3283 | 2742 | −560 | 769 | −7 | C |
| ATOM | 1880 | CG | MET | A | 310 | 1.001 | 97.493 | 57.333 | 1.00 | 32.36 | | C |
| ANISOU | 1880 | CG | MET | A | 310 | 4376 | 4245 | 3674 | −584 | 896 | −50 | C |
| ATOM | 1881 | SD | MET | A | 310 | 2.104 | 98.935 | 57.271 | 1.00 | 33.66 | | S |
| ANISOU | 1881 | SD | MET | A | 310 | 4544 | 4490 | 3754 | −490 | 650 | −5 | S |
| ATOM | 1882 | CE | MET | A | 310 | 1.527 | 99.683 | 55.744 | 1.00 | 30.71 | | C |
| ANISOU | 1882 | CE | MET | A | 310 | 3826 | 4214 | 3629 | −438 | 555 | −74 | C |
| ATOM | 1883 | N | LEU | A | 311 | 0.030 | 94.666 | 53.715 | 1.00 | 31.42 | | N |
| ANISOU | 1883 | N | LEU | A | 311 | 3702 | 4200 | 4038 | −565 | 719 | −91 | N |
| ATOM | 1884 | CA | LEU | A | 311 | 0.372 | 93.904 | 52.523 | 1.00 | 27.92 | | C |
| ANISOU | 1884 | CA | LEU | A | 311 | 3179 | 3791 | 3639 | −511 | 558 | −53 | C |
| ATOM | 1885 | C | LEU | A | 311 | 1.688 | 94.394 | 51.913 | 1.00 | 32.00 | | C |
| ANISOU | 1885 | C | LEU | A | 311 | 3733 | 4392 | 4032 | −411 | 344 | 47 | C |
| ATOM | 1886 | O | LEU | A | 311 | 1.861 | 95.587 | 51.680 | 1.00 | 32.52 | | O |
| ANISOU | 1886 | O | LEU | A | 311 | 3742 | 4504 | 4111 | −360 | 268 | 33 | O |
| ATOM | 1887 | CB | LEU | A | 311 | −0.749 | 94.017 | 51.499 | 1.00 | 23.25 | | C |
| ANISOU | 1887 | CB | LEU | A | 311 | 2345 | 3185 | 3305 | −489 | 519 | −178 | C |
| ATOM | 1888 | CG | LEU | A | 311 | −0.592 | 93.171 | 50.233 | 1.00 | 30.62 | | C |
| ANISOU | 1888 | CG | LEU | A | 311 | 3220 | 4124 | 4291 | −430 | 357 | −158 | C |
| ATOM | 1889 | CD1 | LEU | A | 311 | −0.722 | 91.644 | 50.485 | 1.00 | 23.33 | | C |
| ANISOU | 1889 | CD1 | LEU | A | 311 | 2366 | 3136 | 3362 | −507 | 458 | −134 | C |
| ATOM | 1890 | CD2 | LEU | A | 311 | −1.595 | 93.664 | 49.202 | 1.00 | 23.25 | | C |
| ANISOU | 1890 | CD2 | LEU | A | 311 | 2077 | 3164 | 3591 | −370 | 243 | −293 | C |
| ATOM | 1891 | N | VAL | A | 312 | 2.616 | 93.475 | 51.668 | 1.00 | 26.14 | | N |
| ANISOU | 1891 | N | VAL | A | 312 | 3086 | 3659 | 3188 | −387 | 263 | 141 | N |
| ATOM | 1892 | CA | VAL | A | 312 | 3.869 | 93.819 | 51.023 | 1.00 | 23.51 | | C |
| ANISOU | 1892 | CA | VAL | A | 312 | 2761 | 3386 | 2785 | −300 | 96 | 222 | C |
| ATOM | 1893 | C | VAL | A | 312 | 3.621 | 93.686 | 49.520 | 1.00 | 30.67 | | C |
| ANISOU | 1893 | C | VAL | A | 312 | 3544 | 4309 | 3799 | −233 | 2 | 200 | C |
| ATOM | 1894 | O | VAL | A | 312 | 3.613 | 92.575 | 48.961 | 1.00 | 27.99 | | O |
| ANISOU | 1894 | O | VAL | A | 312 | 3215 | 3947 | 3472 | −224 | −21 | 219 | O |
| ATOM | 1895 | CB | VAL | A | 312 | 5.053 | 92.911 | 51.496 | 1.00 | 25.66 | | C |
| ANISOU | 1895 | CB | VAL | A | 312 | 3189 | 3644 | 2917 | −292 | 44 | 318 | C |
| ATOM | 1896 | CG1 | VAL | A | 312 | 6.380 | 93.394 | 50.905 | 1.00 | 21.53 | | C |
| ANISOU | 1896 | CG1 | VAL | A | 312 | 2635 | 3168 | 2377 | −209 | −101 | 380 | C |
| ATOM | 1897 | CG2 | VAL | A | 312 | 5.161 | 92.901 | 53.014 | 1.00 | 20.61 | | C |
| ANISOU | 1897 | CG2 | VAL | A | 312 | 2738 | 2948 | 2146 | −347 | 118 | 329 | C |
| ATOM | 1898 | N | ASP | A | 313 | 3.416 | 94.823 | 48.863 | 1.00 | 24.23 | | N |
| ANISOU | 1898 | N | ASP | A | 313 | 2644 | 3517 | 3047 | −179 | −61 | 159 | N |
| ATOM | 1899 | CA | ASP | A | 313 | 2.862 | 94.821 | 47.511 | 1.00 | 20.27 | | C |
| ANISOU | 1899 | CA | ASP | A | 313 | 2066 | 2993 | 2643 | −108 | −155 | 108 | C |
| ATOM | 1900 | C | ASP | A | 313 | 3.673 | 95.606 | 46.471 | 1.00 | 22.73 | | C |
| ANISOU | 1900 | C | ASP | A | 313 | 2416 | 3318 | 2903 | −12 | −260 | 156 | C |
| ATOM | 1901 | O | ASP | A | 313 | 3.670 | 96.843 | 46.468 | 1.00 | 26.62 | | O |
| ANISOU | 1901 | O | ASP | A | 313 | 2894 | 3820 | 3399 | 11 | −279 | 134 | O |
| ATOM | 1902 | CB | ASP | A | 313 | 1.447 | 95.371 | 47.572 | 1.00 | 23.89 | | C |
| ANISOU | 1902 | CB | ASP | A | 313 | 2400 | 3415 | 3262 | −124 | −134 | −28 | C |
| ATOM | 1903 | CG | ASP | A | 313 | 0.658 | 95.076 | 46.331 | 1.00 | 29.40 | | C |
| ANISOU | 1903 | CG | ASP | A | 313 | 3027 | 4054 | 4090 | −53 | −260 | −111 | C |
| ATOM | 1904 | OD1 | ASP | A | 313 | 1.233 | 94.557 | 45.350 | 1.00 | 26.91 | | O |
| ANISOU | 1904 | OD1 | ASP | A | 313 | 2792 | 3727 | 3706 | 17 | −359 | −52 | O |
| ATOM | 1905 | OD2 | ASP | A | 313 | −0.545 | 95.391 | 46.337 | 1.00 | 29.06 | | O |
| ANISOU | 1905 | OD2 | ASP | A | 313 | 2851 | 3962 | 4227 | −59 | −267 | −247 | O |
| ATOM | 1906 | N | SER | A | 314 | 4.321 | 94.887 | 45.563 | 1.00 | 20.35 | | N |
| ANISOU | 1906 | N | SER | A | 314 | 2176 | 3001 | 2554 | 43 | −310 | 216 | N |
| ATOM | 1907 | CA | SER | A | 314 | 5.090 | 95.512 | 44.491 | 1.00 | 18.21 | | C |
| ANISOU | 1907 | CA | SER | A | 314 | 1976 | 2712 | 2230 | 130 | −362 | 262 | C |
| ATOM | 1908 | C | SER | A | 314 | 4.180 | 96.143 | 43.424 | 1.00 | 22.89 | | C |
| ANISOU | 1908 | C | SER | A | 314 | 2590 | 3239 | 2867 | 213 | −462 | 181 | C |
| ATOM | 1909 | O | SER | A | 314 | 4.628 | 96.926 | 42.575 | 1.00 | 21.56 | | O |
| ANISOU | 1909 | O | SER | A | 314 | 2522 | 3030 | 2641 | 285 | −492 | 205 | O |
| ATOM | 1910 | CB | SER | A | 314 | 6.021 | 94.472 | 43.871 | 1.00 | 19.82 | | C |
| ANISOU | 1910 | CB | SER | A | 314 | 2253 | 2901 | 2374 | 165 | −357 | 342 | C |
| ATOM | 1911 | OG | SER | A | 314 | 5.253 | 93.422 | 43.321 | 1.00 | 25.26 | | O |
| ANISOU | 1911 | OG | SER | A | 314 | 2956 | 3548 | 3093 | 187 | −410 | 303 | O |
| ATOM | 1912 | N | GLY | A | 315 | 2.899 | 95.784 | 43.473 | 1.00 | 26.88 | | N |
| ANISOU | 1912 | N | GLY | A | 315 | 3012 | 3713 | 3487 | 204 | −515 | 76 | N |
| ATOM | 1913 | CA | GLY | A | 315 | 1.906 | 96.334 | 42.570 | 1.00 | 19.39 | | C |
| ANISOU | 1913 | CA | GLY | A | 315 | 2067 | 2682 | 2618 | 294 | −659 | −33 | C |
| ATOM | 1914 | C | GLY | A | 315 | 1.168 | 97.521 | 43.170 | 1.00 | 19.75 | | C |
| ANISOU | 1914 | C | GLY | A | 315 | 2012 | 2737 | 2756 | 276 | −661 | −124 | C |
| ATOM | 1915 | O | GLY | A | 315 | 0.138 | 97.947 | 42.659 | 1.00 | 24.12 | | O |
| ANISOU | 1915 | O | GLY | A | 315 | 2521 | 3216 | 3426 | 343 | −793 | −248 | O |
| ATOM | 1916 | N | SER | A | 316 | 1.686 | 98.052 | 44.266 | 1.00 | 19.21 | | N |
| ANISOU | 1916 | N | SER | A | 316 | 1909 | 2746 | 2643 | 194 | −532 | −73 | N |
| ATOM | 1917 | CA | SER | A | 316 | 1.139 | 99.279 | 44.798 | 1.00 | 25.71 | | C |
| ANISOU | 1917 | CA | SER | A | 316 | 2666 | 3576 | 3526 | 187 | −527 | −147 | C |
| ATOM | 1918 | C | SER | A | 316 | 2.188 | 100.374 | 44.685 | 1.00 | 21.88 | | C |
| ANISOU | 1918 | C | SER | A | 316 | 2291 | 3113 | 2911 | 213 | −519 | −61 | C |
| ATOM | 1919 | O | SER | A | 316 | 3.222 | 100.337 | 45.360 | 1.00 | 22.22 | | O |
| ANISOU | 1919 | O | SER | A | 316 | 2358 | 3213 | 2870 | 151 | −424 | 35 | O |
| ATOM | 1920 | CB | SER | A | 316 | 0.686 | 99.091 | 46.238 | 1.00 | 25.48 | | C |
| ANISOU | 1920 | CB | SER | A | 316 | 2524 | 3592 | 3566 | 72 | −378 | −184 | C |
| ATOM | 1921 | OG | SER | A | 316 | 0.157 | 100.296 | 46.735 | 1.00 | 26.30 | | O |
| ANISOU | 1921 | OG | SER | A | 316 | 2569 | 3695 | 3727 | 71 | −365 | −260 | O |
| ATOM | 1922 | N | THR | A | 317 | 1.931 | 101.327 | 43.800 | 1.00 | 20.34 | | N |
| ANISOU | 1922 | N | THR | A | 317 | 2170 | 2851 | 2708 | 308 | −630 | −104 | N |
| ATOM | 1923 | CA | THR | A | 317 | 2.888 | 102.399 | 43.535 | 1.00 | 24.67 | | C |
| ANISOU | 1923 | CA | THR | A | 317 | 2842 | 3390 | 3143 | 331 | −608 | −27 | C |
| ATOM | 1924 | C | THR | A | 317 | 3.364 | 103.045 | 44.832 | 1.00 | 26.17 | | C |
| ANISOU | 1924 | C | THR | A | 317 | 2957 | 3660 | 3327 | 238 | −503 | 3 | C |
| ATOM | 1925 | O | THR | A | 317 | 4.560 | 103.250 | 45.038 | 1.00 | 28.04 | | O |
| ANISOU | 1925 | O | THR | A | 317 | 3239 | 3921 | 3493 | 202 | −433 | 99 | O |
| ATOM | 1926 | CB | THR | A | 317 | 2.286 | 103.489 | 42.635 | 1.00 | 25.08 | | C |
| ANISOU | 1926 | CB | THR | A | 317 | 2998 | 3341 | 3189 | 442 | −745 | −102 | C |
| ATOM | 1927 | OG1 | THR | A | 317 | 1.749 | 102.888 | 41.445 | 1.00 | 21.27 | | O |
| ANISOU | 1927 | OG1 | THR | A | 317 | 2616 | 2758 | 2707 | 547 | −885 | −149 | O |
| ATOM | 1928 | CG2 | THR | A | 317 | 3.353 | 104.534 | 42.271 | 1.00 | 19.60 | | C |
| ANISOU | 1928 | CG2 | THR | A | 317 | 2463 | 2614 | 2370 | 455 | −688 | −12 | C |
| ATOM | 1929 | N | PHE | A | 318 | 2.415 | 103.343 | 45.712 | 1.00 | 18.88 | | N |
| ANISOU | 1929 | N | PHE | A | 318 | 1920 | 2761 | 2494 | 202 | −491 | −90 | N |
| ATOM | 1930 | CA | PHE | A | 318 | 2.738 | 104.016 | 46.958 | 1.00 | 19.69 | | C |
| ANISOU | 1930 | CA | PHE | A | 318 | 1990 | 2917 | 2574 | 128 | −404 | −74 | C |
| ATOM | 1931 | C | PHE | A | 318 | 2.472 | 103.136 | 48.167 | 1.00 | 21.99 | | C |
| ANISOU | 1931 | C | PHE | A | 318 | 2213 | 3252 | 2888 | 36 | −294 | −83 | C |
| ATOM | 1932 | O | PHE | A | 318 | 1.821 | 102.105 | 48.073 | 1.00 | 29.11 | | O |
| ANISOU | 1932 | O | PHE | A | 318 | 3061 | 4142 | 3859 | 21 | −272 | −123 | O |
| ATOM | 1933 | CB | PHE | A | 318 | 1.951 | 105.334 | 47.066 | 1.00 | 19.25 | | C |
| ANISOU | 1933 | CB | PHE | A | 318 | 1908 | 2832 | 2574 | 166 | −453 | −172 | C |
| ATOM | 1934 | CG | PHE | A | 318 | 2.142 | 106.247 | 45.880 | 1.00 | 26.51 | | C |
| ANISOU | 1934 | CG | PHE | A | 318 | 2944 | 3679 | 3448 | 264 | −566 | −167 | C |
| ATOM | 1935 | CD1 | PHE | A | 318 | 3.407 | 106.760 | 45.573 | 1.00 | 26.96 | | C |
| ANISOU | 1935 | CD1 | PHE | A | 318 | 3120 | 3727 | 3397 | 256 | −533 | −58 | C |
| ATOM | 1936 | CD2 | PHE | A | 318 | 1.073 | 106.581 | 45.055 | 1.00 | 36.14 | | C |
| ANISOU | 1936 | CD2 | PHE | A | 318 | 4170 | 4817 | 4743 | 365 | −705 | −281 | C |
| ATOM | 1937 | CE1 | PHE | A | 318 | 3.604 | 107.603 | 44.468 | 1.00 | 25.62 | | C |
| ANISOU | 1937 | CE1 | PHE | A | 318 | 3105 | 3463 | 3165 | 339 | −597 | −47 | C |
| ATOM | 1938 | CE2 | PHE | A | 318 | 1.257 | 107.422 | 43.947 | 1.00 | 38.28 | | C |
| ANISOU | 1938 | CE2 | PHE | A | 318 | 4617 | 4992 | 4935 | 467 | −816 | −273 | C |
| ATOM | 1939 | CZ | PHE | A | 318 | 2.533 | 107.937 | 43.658 | 1.00 | 30.83 | | C |
| ANISOU | 1939 | CZ | PHE | A | 318 | 3824 | 4036 | 3854 | 448 | −742 | −148 | C |
| ATOM | 1940 | N | THR | A | 319 | 3.010 | 103.557 | 49.300 | 1.00 | 18.71 | | N |
| ANISOU | 1940 | N | THR | A | 319 | 1831 | 2870 | 2408 | −24 | −227 | −47 | N |
| ATOM | 1941 | CA | THR | A | 319 | 2.716 | 102.981 | 50.597 | 1.00 | 19.16 | | C |
| ANISOU | 1941 | CA | THR | A | 319 | 1894 | 2937 | 2448 | −104 | −110 | −62 | C |
| ATOM | 1942 | C | THR | A | 319 | 1.444 | 103.628 | 51.183 | 1.00 | 28.28 | | C |
| ANISOU | 1942 | C | THR | A | 319 | 2979 | 4067 | 3699 | −119 | −33 | −187 | C |
| ATOM | 1943 | O | THR | A | 319 | 1.329 | 104.856 | 51.215 | 1.00 | 30.12 | | O |
| ANISOU | 1943 | O | THR | A | 319 | 3206 | 4297 | 3941 | −85 | −74 | −225 | O |
| ATOM | 1944 | CB | THR | A | 319 | 3.893 | 103.201 | 51.531 | 1.00 | 21.70 | | C |
| ANISOU | 1944 | CB | THR | A | 319 | 2323 | 3275 | 2646 | −140 | −108 | 22 | C |
| ATOM | 1945 | OG1 | THR | A | 319 | 5.045 | 102.526 | 51.009 | 1.00 | 23.42 | | O |
| ANISOU | 1945 | OG1 | THR | A | 319 | 2571 | 3505 | 2824 | −125 | −169 | 116 | O |
| ATOM | 1946 | CG2 | THR | A | 319 | 3.571 | 102.718 | 52.933 | 1.00 | 26.94 | | C |
| ANISOU | 1946 | CG2 | THR | A | 319 | 3070 | 3918 | 3247 | −209 | 9 | 5 | C |
| ATOM | 1947 | N | HIS | A | 320 | 0.491 | 102.812 | 51.629 | 1.00 | 26.01 | | N |
| ANISOU | 1947 | N | HIS | A | 320 | 2633 | 3751 | 3499 | −171 | 90 | −258 | N |
| ATOM | 1948 | CA | HIS | A | 320 | −0.804 | 103.301 | 52.129 | 1.00 | 25.71 | | C |
| ANISOU | 1948 | CA | HIS | A | 320 | 2490 | 3670 | 3608 | −190 | 200 | −399 | C |
| ATOM | 1949 | C | HIS | A | 320 | −0.978 | 103.061 | 53.614 | 1.00 | 29.35 | | C |
| ANISOU | 1949 | C | HIS | A | 320 | 3050 | 4102 | 4000 | −283 | 416 | −404 | C |
| ATOM | 1950 | O | HIS | A | 320 | −0.777 | 101.947 | 54.084 | 1.00 | 39.13 | | O |
| ANISOU | 1950 | O | HIS | A | 320 | 4378 | 5320 | 5170 | −347 | 517 | −352 | O |
| ATOM | 1951 | CB | HIS | A | 320 | −1.958 | 102.633 | 51.379 | 1.00 | 23.69 | | C |
| ANISOU | 1951 | CB | HIS | A | 320 | 2059 | 3367 | 3576 | −175 | 193 | −517 | C |
| ATOM | 1952 | CG | HIS | A | 320 | −1.935 | 102.897 | 49.908 | 1.00 | 28.54 | | C |
| ANISOU | 1952 | CG | HIS | A | 320 | 2624 | 3975 | 4244 | −64 | −36 | −532 | C |
| ATOM | 1953 | ND1 | HIS | A | 320 | −2.850 | 103.710 | 49.282 | 1.00 | 35.82 | | N |
| ANISOU | 1953 | ND1 | HIS | A | 320 | 3430 | 4846 | 5333 | 20 | −154 | −668 | N |
| ATOM | 1954 | CD2 | HIS | A | 320 | −1.074 | 102.488 | 48.946 | 1.00 | 26.30 | | C |
| ANISOU | 1954 | CD2 | HIS | A | 320 | 2429 | 3711 | 3853 | −13 | −169 | −429 | C |
| ATOM | 1955 | CE1 | HIS | A | 320 | −2.567 | 103.775 | 47.993 | 1.00 | 36.20 | | C |
| ANISOU | 1955 | CE1 | HIS | A | 320 | 3529 | 4873 | 5351 | 121 | −360 | −644 | C |
| ATOM | 1956 | NE2 | HIS | A | 320 | −1.497 | 103.037 | 47.763 | 1.00 | 30.57 | | N |
| ANISOU | 1956 | NE2 | HIS | A | 320 | 2941 | 4203 | 4472 | 98 | −352 | −497 | N |
| ATOM | 1957 | N | ILE | A | 321 | −1.378 | 104.099 | 54.346 | 1.00 | 30.09 | | N |
| ANISOU | 1957 | N | ILE | A | 321 | 3158 | 4176 | 4100 | −286 | 493 | −469 | N |
| ATOM | 1958 | CA | ILE | A | 321 | −1.449 | 104.028 | 55.802 | 1.00 | 24.82 | | C |
| ANISOU | 1958 | CA | ILE | A | 321 | 2654 | 3458 | 3319 | −362 | 701 | −467 | C |
| ATOM | 1959 | C | ILE | A | 321 | −2.744 | 104.634 | 56.298 | 1.00 | 26.41 | | C |
| ANISOU | 1959 | C | ILE | A | 321 | 2749 | 3597 | 3688 | −382 | 886 | −623 | C |
| ATOM | 1960 | O | ILE | A | 321 | −3.401 | 105.361 | 55.565 | 1.00 | 26.50 | | O |
| ANISOU | 1960 | O | ILE | A | 321 | 2565 | 3617 | 3887 | −319 | 795 | −727 | O |
| ATOM | 1961 | CB | ILE | A | 321 | −0.264 | 104.752 | 56.444 | 1.00 | 32.00 | | C |
| ANISOU | 1961 | CB | ILE | A | 321 | 3768 | 4390 | 4001 | −341 | 603 | −365 | C |
| ATOM | 1962 | CG1 | ILE | A | 321 | −0.187 | 106.195 | 55.934 | 1.00 | 32.44 | | C |
| ANISOU | 1962 | CG1 | ILE | A | 321 | 3740 | 4483 | 4104 | −268 | 456 | −399 | C |
| ATOM | 1963 | CG2 | ILE | A | 321 | 1.025 | 103.998 | 56.185 | 1.00 | 23.12 | | C |
| ANISOU | 1963 | CG2 | ILE | A | 321 | 2744 | 3300 | 2739 | −334 | 461 | −229 | C |
| ATOM | 1964 | CD1 | ILE | A | 321 | 0.863 | 107.032 | 56.650 | 1.00 | 34.63 | | C |
| ANISOU | 1964 | CD1 | ILE | A | 321 | 4196 | 4764 | 4199 | −255 | 368 | −325 | C |
| ATOM | 1965 | N | PRO | A | 322 | −3.125 | 104.339 | 57.547 | 1.00 | 29.90 | | N |
| ANISOU | 1965 | N | PRO | A | 322 | 3335 | 3958 | 4067 | −463 | 1153 | −648 | N |
| ATOM | 1966 | CA | PRO | A | 322 | −4.391 | 104.900 | 58.047 | 1.00 | 35.74 | | C |
| ANISOU | 1966 | CA | PRO | A | 322 | 3960 | 4623 | 4998 | −488 | 1378 | −811 | C |
| ATOM | 1967 | C | PRO | A | 322 | −4.379 | 106.435 | 58.155 | 1.00 | 37.44 | | C |
| ANISOU | 1967 | C | PRO | A | 322 | 4164 | 4863 | 5198 | −413 | 1280 | −856 | C |
| ATOM | 1968 | O | PRO | A | 322 | −3.327 | 107.053 | 58.261 | 1.00 | 37.03 | | O |
| ANISOU | 1968 | O | PRO | A | 322 | 4273 | 4864 | 4934 | −369 | 1104 | −747 | O |
| ATOM | 1969 | CB | PRO | A | 322 | −4.522 | 104.271 | 59.435 | 1.00 | 36.10 | | C |
| ANISOU | 1969 | CB | PRO | A | 322 | 4263 | 4559 | 4895 | −590 | 1699 | −793 | C |
| ATOM | 1970 | CG | PRO | A | 322 | −3.675 | 103.046 | 59.378 | 1.00 | 35.97 | | C |
| ANISOU | 1970 | CG | PRO | A | 322 | 4409 | 4553 | 4705 | −624 | 1636 | −655 | C |
| ATOM | 1971 | CD | PRO | A | 322 | −2.533 | 103.392 | 58.501 | 1.00 | 28.33 | | C |
| ANISOU | 1971 | CD | PRO | A | 322 | 3415 | 3707 | 3642 | −534 | 1280 | −546 | C |
| ATOM | 1972 | N | GLU | A | 323 | −5.565 | 107.025 | 58.157 | 1.00 | 41.21 | | N |
| ANISOU | 1972 | N | GLU | A | 323 | 4443 | 5290 | 5925 | −401 | 1399 | −1027 | N |
| ATOM | 1973 | CA | GLU | A | 323 | −5.725 | 108.467 | 58.101 | 1.00 | 45.50 | | C |
| ANISOU | 1973 | CA | GLU | A | 323 | 4936 | 5849 | 6502 | −318 | 1292 | −1094 | C |
| ATOM | 1974 | C | GLU | A | 323 | −5.098 | 109.173 | 59.298 | 1.00 | 45.12 | | C |
| ANISOU | 1974 | C | GLU | A | 323 | 5182 | 5782 | 6180 | −330 | 1371 | −1022 | C |
| ATOM | 1975 | O | GLU | A | 323 | −4.266 | 110.074 | 59.128 | 1.00 | 41.73 | | O |
| ANISOU | 1975 | O | GLU | A | 323 | 4843 | 5410 | 5603 | −266 | 1148 | −947 | O |
| ATOM | 1976 | CB | GLU | A | 323 | −7.217 | 108.801 | 58.001 | 1.00 | 56.24 | | C |
| ANISOU | 1976 | CB | GLU | A | 323 | 6016 | 7134 | 8220 | −306 | 1437 | −1316 | C |
| ATOM | 1977 | CG | GLU | A | 323 | −7.528 | 110.250 | 57.669 | 1.00 | 69.88 | | C |
| ANISOU | 1977 | CG | GLU | A | 323 | 7639 | 8872 | 10040 | −196 | 1273 | −1413 | C |
| ATOM | 1978 | CD | GLU | A | 323 | −9.006 | 110.479 | 57.383 | 1.00 | 80.24 | | C |
| ANISOU | 1978 | CD | GLU | A | 323 | 8623 | 10100 | 11765 | −164 | 1357 | −1655 | C |
| ATOM | 1979 | OE1 | GLU | A | 323 | −9.856 | 109.944 | 58.126 | 1.00 | 82.82 | | O |
| ANISOU | 1979 | OE1 | GLU | A | 323 | 8868 | 10332 | 12268 | −254 | 1695 | −1768 | O |
| ATOM | 1980 | OE2 | GLU | A | 323 | −9.314 | 111.192 | 56.405 | 1.00 | 84.54 | | O |
| ANISOU | 1980 | OE2 | GLU | A | 323 | 8999 | 10655 | 12468 | −46 | 1083 | −1743 | O |
| ATOM | 1981 | N | ASP | A | 324 | −5.522 | 108.772 | 60.495 | 1.00 | 42.97 | | N |
| ANISOU | 1981 | N | ASP | A | 324 | 5071 | 5407 | 5846 | −412 | 1696 | −1054 | N |
| ATOM | 1982 | CA | ASP | A | 324 | −4.895 | 109.188 | 61.751 | 1.00 | 47.04 | | C |
| ANISOU | 1982 | CA | ASP | A | 324 | 5948 | 5870 | 6056 | −426 | 1782 | −978 | C |
| ATOM | 1983 | C | ASP | A | 324 | −3.372 | 109.183 | 61.640 | 1.00 | 45.25 | | C |
| ANISOU | 1983 | C | ASP | A | 324 | 5920 | 5715 | 5557 | −390 | 1483 | −800 | C |
| ATOM | 1984 | O | ASP | A | 324 | −2.712 | 110.159 | 61.986 | 1.00 | 44.35 | | O |
| ANISOU | 1984 | O | ASP | A | 324 | 5949 | 5613 | 5291 | −339 | 1334 | −760 | O |
| ATOM | 1985 | CB | ASP | A | 324 | −5.387 | 108.310 | 62.907 | 1.00 | 56.73 | | C |
| ANISOU | 1985 | CB | ASP | A | 324 | 7396 | 6956 | 7204 | −528 | 2170 | −998 | C |
| ATOM | 1986 | CG | ASP | A | 324 | −5.190 | 106.825 | 62.640 | 1.00 | 70.83 | | C |
| ANISOU | 1986 | CG | ASP | A | 324 | 9198 | 8735 | 8979 | −598 | 2210 | −925 | C |
| ATOM | 1987 | OD1 | ASP | A | 324 | −6.091 | 106.200 | 62.019 | 1.00 | 73.02 | | O |
| ANISOU | 1987 | OD1 | ASP | A | 324 | 9190 | 9003 | 9552 | −641 | 2328 | −1024 | O |
| ATOM | 1988 | OD2 | ASP | A | 324 | −4.142 | 106.277 | 63.053 | 1.00 | 75.56 | | O |
| ANISOU | 1988 | OD2 | ASP | A | 324 | 10091 | 9328 | 9289 | −605 | 2110 | −779 | O |
| ATOM | 1989 | N | LEU | A | 325 | −2.815 | 108.090 | 61.134 | 1.00 | 41.38 | | N |
| ANISOU | 1989 | N | LEU | A | 325 | 5422 | 5266 | 5035 | −416 | 1390 | −706 | N |
| ATOM | 1990 | CA | LEU | A | 325 | −1.373 | 107.962 | 61.052 | 1.00 | 32.65 | | C |
| ANISOU | 1990 | CA | LEU | A | 325 | 4479 | 4211 | 3716 | −386 | 1129 | −555 | C |
| ATOM | 1991 | C | LEU | A | 325 | −0.836 | 108.952 | 60.024 | 1.00 | 32.34 | | C |
| ANISOU | 1991 | C | LEU | A | 325 | 4263 | 4273 | 3753 | −308 | 843 | −536 | C |
| ATOM | 1992 | O | LEU | A | 325 | 0.107 | 109.685 | 60.305 | 1.00 | 34.85 | | O |
| ANISOU | 1992 | O | LEU | A | 325 | 4713 | 4599 | 3928 | −273 | 674 | −473 | O |
| ATOM | 1993 | CB | LEU | A | 325 | −0.995 | 106.530 | 60.693 | 1.00 | 31.16 | | C |
| ANISOU | 1993 | CB | LEU | A | 325 | 4300 | 4034 | 3505 | −427 | 1115 | −475 | C |
| ATOM | 1994 | CG | LEU | A | 325 | 0.465 | 106.109 | 60.559 | 1.00 | 33.25 | | C |
| ANISOU | 1994 | CG | LEU | A | 325 | 4698 | 4338 | 3598 | −400 | 866 | −334 | C |
| ATOM | 1995 | CD1 | LEU | A | 325 | 1.354 | 106.872 | 61.498 | 1.00 | 30.63 | | C |
| ANISOU | 1995 | CD1 | LEU | A | 325 | 4625 | 3958 | 3054 | −365 | 745 | −288 | C |
| ATOM | 1996 | CD2 | LEU | A | 325 | 0.554 | 104.607 | 60.854 | 1.00 | 31.68 | | C |
| ANISOU | 1996 | CD2 | LEU | A | 325 | 4635 | 4084 | 3317 | −457 | 972 | −280 | C |
| ATOM | 1997 | N | TYR | A | 326 | −1.465 | 108.991 | 58.854 | 1.00 | 26.88 | | N |
| ANISOU | 1997 | N | TYR | A | 326 | 3291 | 3635 | 3287 | −280 | 792 | −600 | N |
| ATOM | 1998 | CA | TYR | A | 326 | −1.036 | 109.860 | 57.777 | 1.00 | 28.10 | | C |
| ANISOU | 1998 | CA | TYR | A | 326 | 3318 | 3858 | 3503 | −204 | 545 | −583 | C |
| ATOM | 1999 | C | TYR | A | 326 | −1.009 | 111.340 | 58.203 | 1.00 | 29.05 | | C |
| ANISOU | 1999 | C | TYR | A | 326 | 3498 | 3962 | 3579 | −160 | 494 | −624 | C |
| ATOM | 2000 | O | TYR | A | 326 | −0.045 | 112.038 | 57.941 | 1.00 | 30.74 | | O |
| ANISOU | 2000 | O | TYR | A | 326 | 3769 | 4204 | 3706 | −126 | 305 | −550 | O |
| ATOM | 2001 | CB | TYR | A | 326 | −1.943 | 109.700 | 56.556 | 1.00 | 31.12 | | C |
| ANISOU | 2001 | CB | TYR | A | 326 | 3439 | 4258 | 4126 | −164 | 503 | −675 | C |
| ATOM | 2002 | CG | TYR | A | 326 | −1.492 | 110.585 | 55.413 | 1.00 | 34.29 | | C |
| ANISOU | 2002 | CG | TYR | A | 326 | 3778 | 4700 | 4551 | −78 | 257 | −652 | C |
| ATOM | 2003 | CD1 | TYR | A | 326 | −0.454 | 110.189 | 54.587 | 1.00 | 28.78 | | C |
| ANISOU | 2003 | CD1 | TYR | A | 326 | 3114 | 4044 | 3776 | −65 | 105 | −531 | C |
| ATOM | 2004 | CD2 | TYR | A | 326 | −2.082 | 111.835 | 55.181 | 1.00 | 33.22 | | C |
| ANISOU | 2004 | CD2 | TYR | A | 326 | 3575 | 4542 | 4507 | −8 | 192 | −751 | C |
| ATOM | 2005 | CE1 | TYR | A | 326 | −0.011 | 110.996 | 53.555 | 1.00 | 26.56 | | C |
| ANISOU | 2005 | CE1 | TYR | A | 326 | 2821 | 3772 | 3498 | 5 | −76 | −504 | C |
| ATOM | 2006 | CE2 | TYR | A | 326 | −1.657 | 112.637 | 54.149 | 1.00 | 24.02 | | C |
| ANISOU | 2006 | CE2 | TYR | A | 326 | 2405 | 3386 | 3334 | 69 | −18 | −724 | C |
| ATOM | 2007 | CZ | TYR | A | 326 | −0.611 | 112.211 | 53.337 | 1.00 | 36.14 | | C |
| ANISOU | 2007 | CZ | TYR | A | 326 | 3998 | 4954 | 4781 | 71 | −138 | −596 | C |
| ATOM | 2008 | OH | TYR | A | 326 | −0.151 | 112.993 | 52.304 | 1.00 | 37.14 | | O |
| ANISOU | 2008 | OH | TYR | A | 326 | 4162 | 5065 | 4885 | 139 | −304 | −563 | O |
| ATOM | 2009 | N | ASN | A | 327 | −2.068 | 111.801 | 58.862 | 1.00 | 27.34 | | N |
| ANISOU | 2009 | N | ASN | A | 327 | 3261 | 3687 | 3439 | −163 | 677 | −748 | N |
| ATOM | 2010 | CA | ASN | A | 327 | −2.165 | 113.202 | 59.260 | 1.00 | 38.46 | | C |
| ANISOU | 2010 | CA | ASN | A | 327 | 4721 | 5073 | 4818 | −114 | 638 | −801 | C |
| ATOM | 2011 | C | ASN | A | 327 | −1.082 | 113.649 | 60.229 | 1.00 | 40.72 | | C |
| ANISOU | 2011 | C | ASN | A | 327 | 5285 | 5335 | 4851 | −125 | 573 | −705 | C |
| ATOM | 2012 | O | ASN | A | 327 | −0.665 | 114.804 | 60.200 | 1.00 | 38.55 | | O |
| ANISOU | 2012 | O | ASN | A | 327 | 5048 | 5064 | 4535 | −79 | 427 | −700 | O |
| ATOM | 2013 | CB | ASN | A | 327 | −3.534 | 113.480 | 59.858 | 1.00 | 31.42 | | C |
| ANISOU | 2013 | CB | ASN | A | 327 | 3755 | 4111 | 4073 | −118 | 886 | −964 | C |
| ATOM | 2014 | CG | ASN | A | 327 | −4.613 | 113.474 | 58.810 | 1.00 | 39.78 | | C |
| ANISOU | 2014 | CG | ASN | A | 327 | 4501 | 5177 | 5438 | −73 | 861 | −1099 | C |
| ATOM | 2015 | OD1 | ASN | A | 327 | −4.344 | 113.758 | 57.638 | 1.00 | 44.26 | | O |
| ANISOU | 2015 | OD1 | ASN | A | 327 | 4957 | 5795 | 6066 | −7 | 614 | −1077 | O |
| ATOM | 2016 | ND2 | ASN | A | 327 | −5.840 | 113.137 | 59.211 | 1.00 | 37.86 | | N |
| ANISOU | 2016 | ND2 | ASN | A | 327 | 4122 | 4862 | 5400 | −105 | 1117 | −1248 | N |
| ATOM | 2017 | N | LYS | A | 328 | −0.637 | 112.739 | 61.086 | 1.00 | 38.36 | | N |
| ANISOU | 2017 | N | LYS | A | 328 | 5193 | 4993 | 4388 | −180 | 666 | −637 | N |
| ATOM | 2018 | CA | LYS | A | 328 | 0.435 | 113.061 | 62.010 | 1.00 | 34.43 | | C |
| ANISOU | 2018 | CA | LYS | A | 328 | 4977 | 4448 | 3657 | −175 | 554 | −557 | C |
| ATOM | 2019 | C | LYS | A | 328 | 1.731 | 113.225 | 61.235 | 1.00 | 31.06 | | C |
| ANISOU | 2019 | C | LYS | A | 328 | 4489 | 4087 | 3226 | −152 | 263 | −455 | C |
| ATOM | 2020 | O | LYS | A | 328 | 2.383 | 114.250 | 61.371 | 1.00 | 35.51 | | O |
| ANISOU | 2020 | O | LYS | A | 328 | 5109 | 4639 | 3745 | −121 | 102 | −441 | O |
| ATOM | 2021 | CB | LYS | A | 328 | 0.558 | 111.992 | 63.090 | 1.00 | 29.57 | | C |
| ANISOU | 2021 | CB | LYS | A | 328 | 4635 | 3742 | 2857 | −224 | 704 | −518 | C |
| ATOM | 2022 | CG | LYS | A | 328 | −0.642 | 111.972 | 64.050 | 1.00 | 43.27 | | C |
| ANISOU | 2022 | CG | LYS | A | 328 | 6498 | 5372 | 4569 | −256 | 1045 | −621 | C |
| ATOM | 2023 | CD | LYS | A | 328 | −0.558 | 110.804 | 65.036 | 1.00 | 40.49 | | C |
| ANISOU | 2023 | CD | LYS | A | 328 | 6461 | 4905 | 4018 | −309 | 1224 | −575 | C |
| ATOM | 2024 | CE | LYS | A | 328 | −1.605 | 110.900 | 66.125 | 1.00 | 46.05 | | C |
| ANISOU | 2024 | CE | LYS | A | 328 | 7369 | 5467 | 4660 | −343 | 1594 | −670 | C |
| ATOM | 2025 | NZ | LYS | A | 328 | −1.558 | 109.707 | 67.022 | 1.00 | 54.72 | | N |
| ANISOU | 2025 | NZ | LYS | A | 328 | 8813 | 6428 | 5549 | −400 | 1796 | −622 | N |
| ATOM | 2026 | N | LEU | A | 329 | 2.091 | 112.237 | 60.410 | 1.00 | 30.27 | | N |
| ANISOU | 2026 | N | LEU | A | 329 | 4267 | 4043 | 3190 | −171 | 212 | −392 | N |
| ATOM | 2027 | CA | LEU | A | 329 | 3.281 | 112.342 | 59.558 | 1.00 | 25.92 | | C |
| ANISOU | 2027 | CA | LEU | A | 329 | 3633 | 3544 | 2672 | −154 | −17 | −306 | C |
| ATOM | 2028 | C | LEU | A | 329 | 3.231 | 113.598 | 58.686 | 1.00 | 27.53 | | C |
| ANISOU | 2028 | C | LEU | A | 329 | 3695 | 3780 | 2986 | −112 | −119 | −335 | C |
| ATOM | 2029 | O | LEU | A | 329 | 4.232 | 114.305 | 58.528 | 1.00 | 26.40 | | O |
| ANISOU | 2029 | O | LEU | A | 329 | 3571 | 3628 | 2831 | −102 | −280 | −289 | O |
| ATOM | 2030 | CB | LEU | A | 329 | 3.435 | 111.122 | 58.648 | 1.00 | 29.73 | | C |
| ANISOU | 2030 | CB | LEU | A | 329 | 3987 | 4080 | 3228 | −172 | −17 | −252 | C |
| ATOM | 2031 | CG | LEU | A | 329 | 3.739 | 109.744 | 59.222 | 1.00 | 41.15 | | C |
| ANISOU | 2031 | CG | LEU | A | 329 | 5561 | 5498 | 4575 | −210 | 37 | −200 | C |
| ATOM | 2032 | CD1 | LEU | A | 329 | 3.764 | 108.732 | 58.095 | 1.00 | 40.94 | | C |
| ANISOU | 2032 | CD1 | LEU | A | 329 | 5369 | 5532 | 4654 | −217 | 30 | −161 | C |
| ATOM | 2033 | CD2 | LEU | A | 329 | 5.081 | 109.736 | 59.952 | 1.00 | 38.38 | | C |
| ANISOU | 2033 | CD2 | LEU | A | 329 | 5393 | 5096 | 4094 | −201 | −138 | −133 | C |
| ATOM | 2034 | N | ASN | A | 330 | 2.067 | 113.842 | 58.094 | 1.00 | 28.35 | | N |
| ANISOU | 2034 | N | ASN | A | 330 | 3655 | 3903 | 3212 | −85 | −30 | −421 | N |
| ATOM | 2035 | CA | ASN | A | 330 | 1.919 | 114.929 | 57.140 | 1.00 | 34.59 | | C |
| ANISOU | 2035 | CA | ASN | A | 330 | 4338 | 4706 | 4099 | −31 | −137 | −454 | C |
| ATOM | 2036 | C | ASN | A | 330 | 2.054 | 116.299 | 57.778 | 1.00 | 34.41 | | C |
| ANISOU | 2036 | C | ASN | A | 330 | 4416 | 4640 | 4018 | −8 | −189 | −487 | C |
| ATOM | 2037 | O | ASN | A | 330 | 2.426 | 117.262 | 57.117 | 1.00 | 37.90 | | O |
| ANISOU | 2037 | O | ASN | A | 330 | 4834 | 5076 | 4492 | 24 | −315 | −476 | O |
| ATOM | 2038 | CB | ASN | A | 330 | 0.581 | 114.830 | 56.429 | 1.00 | 36.65 | | C |
| ANISOU | 2038 | CB | ASN | A | 330 | 4434 | 4974 | 4519 | 11 | −68 | −561 | C |
| ATOM | 2039 | CG | ASN | A | 330 | 0.621 | 115.443 | 55.050 | 1.00 | 35.63 | | C |
| ANISOU | 2039 | CG | ASN | A | 330 | 4221 | 4847 | 4471 | 78 | −223 | −563 | C |
| ATOM | 2040 | OD1 | ASN | A | 330 | 1.618 | 115.335 | 54.336 | 1.00 | 29.73 | | O |
| ANISOU | 2040 | OD1 | ASN | A | 330 | 3503 | 4112 | 3681 | 73 | −323 | −463 | O |
| ATOM | 2041 | ND2 | ASN | A | 330 | −0.476 | 116.043 | 54.649 | 1.00 | 34.12 | | N |
| ANISOU | 2041 | ND2 | ASN | A | 330 | 3937 | 4626 | 4402 | 147 | −237 | −686 | N |
| ATOM | 2042 | N | TYR | A | 331 | 1.743 | 116.384 | 59.064 | 1.00 | 30.49 | | N |
| ANISOU | 2042 | N | TYR | A | 331 | 4060 | 4099 | 3425 | −25 | −82 | −528 | N |
| ATOM | 2043 | CA | TYR | A | 331 | 1.908 | 117.625 | 59.791 | 1.00 | 35.00 | | C |
| ANISOU | 2043 | CA | TYR | A | 331 | 4761 | 4619 | 3921 | −1 | −136 | −560 | C |
| ATOM | 2044 | C | TYR | A | 331 | 3.398 | 117.985 | 59.846 | 1.00 | 36.32 | | C |
| ANISOU | 2044 | C | TYR | A | 331 | 5014 | 4768 | 4018 | −18 | −337 | −464 | C |
| ATOM | 2045 | O | TYR | A | 331 | 3.780 | 119.129 | 59.581 | 1.00 | 35.99 | | O |
| ANISOU | 2045 | O | TYR | A | 331 | 4970 | 4705 | 4001 | 4 | −457 | −468 | O |
| ATOM | 2046 | CB | TYR | A | 331 | 1.312 | 117.509 | 61.191 | 1.00 | 27.25 | | C |
| ANISOU | 2046 | CB | TYR | A | 331 | 3960 | 3569 | 2823 | −13 | 41 | −619 | C |
| ATOM | 2047 | CG | TYR | A | 331 | 1.080 | 118.840 | 61.849 | 1.00 | 45.43 | | C |
| ANISOU | 2047 | CG | TYR | A | 331 | 6375 | 5814 | 5073 | 28 | 27 | −686 | C |
| ATOM | 2048 | CD2 | TYR | A | 331 | 1.935 | 119.313 | 62.834 | 1.00 | 41.76 | | C |
| ANISOU | 2048 | CD2 | TYR | A | 331 | 6152 | 5278 | 4435 | 28 | −79 | −648 | C |
| ATOM | 2049 | CD1 | TYR | A | 331 | −0.005 | 119.632 | 61.481 | 1.00 | 51.85 | | C |
| ANISOU | 2049 | CD1 | TYR | A | 331 | 7053 | 6629 | 6018 | 77 | 97 | −799 | C |
| ATOM | 2050 | CE2 | TYR | A | 331 | 1.723 | 120.533 | 63.430 | 1.00 | 39.01 | | C |
| ANISOU | 2050 | CE2 | TYR | A | 331 | 5919 | 4870 | 4032 | 69 | −99 | −711 | C |
| ATOM | 2051 | CE1 | TYR | A | 331 | −0.221 | 120.856 | 62.068 | 1.00 | 50.89 | | C |
| ANISOU | 2051 | CE1 | TYR | A | 331 | 7035 | 6452 | 5849 | 120 | 84 | −864 | C |
| ATOM | 2052 | CZ | TYR | A | 331 | 0.644 | 121.299 | 63.042 | 1.00 | 48.80 | | C |
| ANISOU | 2052 | CZ | TYR | A | 331 | 7021 | 6123 | 5396 | 112 | −6 | −815 | C |
| ATOM | 2053 | OH | TYR | A | 331 | 0.418 | 122.520 | 63.630 | 1.00 | 63.22 | | O |
| ANISOU | 2053 | OH | TYR | A | 331 | 8965 | 7887 | 7169 | 159 | −24 | −881 | O |
| ATOM | 2054 | N | PHE | A | 332 | 4.241 | 117.004 | 60.168 | 1.00 | 32.93 | | N |
| ANISOU | 2054 | N | PHE | A | 332 | 4653 | 4335 | 3525 | −55 | −379 | −388 | N |
| ATOM | 2055 | CA | PHE | A | 332 | 5.679 | 117.246 | 60.170 | 1.00 | 32.87 | | C |
| ANISOU | 2055 | CA | PHE | A | 332 | 4677 | 4297 | 3514 | −70 | −579 | −319 | C |
| ATOM | 2056 | C | PHE | A | 332 | 6.173 | 117.501 | 58.743 | 1.00 | 29.97 | | C |
| ANISOU | 2056 | C | PHE | A | 332 | 4117 | 3973 | 3296 | −76 | −645 | −275 | C |
| ATOM | 2057 | O | PHE | A | 332 | 6.991 | 118.383 | 58.512 | 1.00 | 26.93 | | O |
| ANISOU | 2057 | O | PHE | A | 332 | 3719 | 3550 | 2965 | −83 | −766 | −258 | O |
| ATOM | 2058 | CB | PHE | A | 332 | 6.445 | 116.084 | 60.806 | 1.00 | 34.07 | | C |
| ANISOU | 2058 | CB | PHE | A | 332 | 4938 | 4421 | 3587 | −93 | −630 | −265 | C |
| ATOM | 2059 | CG | PHE | A | 332 | 6.404 | 116.070 | 62.319 | 1.00 | 41.79 | | C |
| ANISOU | 2059 | CG | PHE | A | 332 | 6200 | 5301 | 4376 | −78 | −635 | −295 | C |
| ATOM | 2060 | CD1 | PHE | A | 332 | 5.866 | 117.121 | 63.026 | 1.00 | 48.29 | | C |
| ANISOU | 2060 | CD1 | PHE | A | 332 | 7157 | 6071 | 5122 | −51 | −601 | −361 | C |
| ATOM | 2061 | CD2 | PHE | A | 332 | 6.941 | 115.014 | 63.031 | 1.00 | 48.81 | | C |
| ANISOU | 2061 | CD2 | PHE | A | 332 | 7259 | 6134 | 5153 | −81 | −685 | −258 | C |
| ATOM | 2062 | CE1 | PHE | A | 332 | 5.840 | 117.107 | 64.416 | 1.00 | 51.46 | | C |
| ANISOU | 2062 | CE1 | PHE | A | 332 | 7872 | 6359 | 5322 | −29 | −597 | −388 | C |
| ATOM | 2063 | CE2 | PHE | A | 332 | 6.923 | 114.996 | 64.415 | 1.00 | 48.46 | | C |
| ANISOU | 2063 | CE2 | PHE | A | 332 | 7543 | 5968 | 4900 | −55 | −700 | −285 | C |
| ATOM | 2064 | CZ | PHE | A | 332 | 6.375 | 116.043 | 65.109 | 1.00 | 45.64 | | C |
| ANISOU | 2064 | CZ | PHE | A | 332 | 7335 | 5552 | 4453 | −29 | −649 | −348 | C |
| ATOM | 2065 | N | PHE | A | 333 | 5.672 | 116.748 | 57.772 | 1.00 | 23.09 | | N |
| ANISOU | 2065 | N | PHE | A | 333 | 3117 | 3164 | 2492 | −72 | −559 | −261 | N |
| ATOM | 2066 | CA | PHE | A | 333 | 6.141 | 116.968 | 56.422 | 1.00 | 25.48 | | C |
| ANISOU | 2066 | CA | PHE | A | 333 | 3301 | 3480 | 2901 | −69 | −606 | −218 | C |
| ATOM | 2067 | C | PHE | A | 333 | 5.718 | 118.359 | 55.891 | 1.00 | 35.55 | | C |
| ANISOU | 2067 | C | PHE | A | 333 | 4574 | 4723 | 4210 | −31 | −634 | −264 | C |
| ATOM | 2068 | O | PHE | A | 333 | 6.453 | 118.958 | 55.112 | 1.00 | 40.81 | | O |
| ANISOU | 2068 | O | PHE | A | 333 | 5223 | 5352 | 4931 | −40 | −690 | −223 | O |
| ATOM | 2069 | CB | PHE | A | 333 | 5.663 | 115.861 | 55.495 | 1.00 | 28.43 | | C |
| ANISOU | 2069 | CB | PHE | A | 333 | 3575 | 3908 | 3320 | −60 | −528 | −199 | C |
| ATOM | 2070 | CG | PHE | A | 333 | 6.524 | 114.620 | 55.551 | 1.00 | 34.92 | | C |
| ANISOU | 2070 | CG | PHE | A | 333 | 4382 | 4749 | 4138 | −98 | −537 | −125 | C |
| ATOM | 2071 | CD1 | PHE | A | 333 | 7.880 | 114.695 | 55.262 | 1.00 | 28.77 | | C |
| ANISOU | 2071 | CD1 | PHE | A | 333 | 3576 | 3939 | 3417 | −125 | −624 | −62 | C |
| ATOM | 2072 | CD2 | PHE | A | 333 | 5.985 | 113.383 | 55.910 | 1.00 | 31.42 | | C |
| ANISOU | 2072 | CD2 | PHE | A | 333 | 3946 | 4339 | 3654 | −108 | −453 | −128 | C |
| ATOM | 2073 | CE1 | PHE | A | 333 | 8.688 | 113.572 | 55.318 | 1.00 | 21.18 | | C |
| ANISOU | 2073 | CE1 | PHE | A | 333 | 2586 | 2985 | 2476 | −149 | −648 | −9 | C |
| ATOM | 2074 | CE2 | PHE | A | 333 | 6.788 | 112.253 | 55.972 | 1.00 | 24.29 | | C |
| ANISOU | 2074 | CE2 | PHE | A | 333 | 3045 | 3443 | 2740 | −134 | −478 | −63 | C |
| ATOM | 2075 | CZ | PHE | A | 333 | 8.143 | 112.346 | 55.676 | 1.00 | 24.06 | | C |
| ANISOU | 2075 | CZ | PHE | A | 333 | 2981 | 3388 | 2771 | −148 | −587 | −6 | C |
| ATOM | 2076 | N | ASP | A | 334 | 4.559 | 118.869 | 56.318 | 1.00 | 27.63 | | N |
| ANISOU | 2076 | N | ASP | A | 334 | 3598 | 3719 | 3181 | 12 | −582 | −354 | N |
| ATOM | 2077 | CA | ASP | A | 334 | 4.111 | 120.208 | 55.919 | 1.00 | 29.11 | | C |
| ANISOU | 2077 | CA | ASP | A | 334 | 3801 | 3865 | 3394 | 62 | −629 | −411 | C |
| ATOM | 2078 | C | ASP | A | 334 | 5.075 | 121.296 | 56.384 | 1.00 | 28.10 | | C |
| ANISOU | 2078 | C | ASP | A | 334 | 3765 | 3674 | 3237 | 35 | −730 | −385 | C |
| ATOM | 2079 | O | ASP | A | 334 | 5.404 | 122.205 | 55.638 | 1.00 | 33.87 | | O |
| ANISOU | 2079 | O | ASP | A | 334 | 4508 | 4356 | 4006 | 44 | −788 | −371 | O |
| ATOM | 2080 | CB | ASP | A | 334 | 2.715 | 120.509 | 56.467 | 1.00 | 34.87 | | C |
| ANISOU | 2080 | CB | ASP | A | 334 | 4525 | 4596 | 4128 | 115 | −550 | −531 | C |
| ATOM | 2081 | CG | ASP | A | 334 | 1.602 | 119.977 | 55.572 | 1.00 | 41.06 | | C |
| ANISOU | 2081 | CG | ASP | A | 334 | 5179 | 5405 | 5018 | 169 | −504 | −597 | C |
| ATOM | 2082 | OD1 | ASP | A | 334 | 1.866 | 119.648 | 54.386 | 1.00 | 36.14 | | O |
| ANISOU | 2082 | OD1 | ASP | A | 334 | 4512 | 4785 | 4435 | 185 | −564 | −549 | O |
| ATOM | 2083 | OD2 | ASP | A | 334 | 0.458 | 119.873 | 56.079 | 1.00 | 44.27 | | O |
| ANISOU | 2083 | OD2 | ASP | A | 334 | 5531 | 5811 | 5479 | 196 | −403 | −706 | O |
| ATOM | 2084 | N | ILE | A | 335 | 5.544 | 121.179 | 57.611 | 1.00 | 24.17 | | N |
| ANISOU | 2084 | N | ILE | A | 335 | 3354 | 3159 | 2669 | 2 | −755 | −381 | N |
| ATOM | 2085 | CA | ILE | A | 335 | 6.493 | 122.130 | 58.136 | 1.00 | 25.96 | | C |
| ANISOU | 2085 | CA | ILE | A | 335 | 3662 | 3312 | 2889 | −23 | −880 | −370 | C |
| ATOM | 2086 | C | ILE | A | 335 | 7.827 | 122.043 | 57.390 | 1.00 | 26.31 | | C |
| ANISOU | 2086 | C | ILE | A | 335 | 3624 | 3327 | 3046 | −79 | −952 | −291 | C |
| ATOM | 2087 | O | ILE | A | 335 | 8.431 | 123.067 | 57.075 | 1.00 | 26.44 | | O |
| ANISOU | 2087 | O | ILE | A | 335 | 3645 | 3273 | 3129 | −100 | −1016 | −286 | O |
| ATOM | 2088 | CB | ILE | A | 335 | 6.677 | 121.914 | 59.646 | 1.00 | 34.70 | | C |
| ANISOU | 2088 | CB | ILE | A | 335 | 4919 | 4384 | 3883 | −28 | −920 | −392 | C |
| ATOM | 2089 | CG1 | ILE | A | 335 | 5.357 | 122.240 | 60.368 | 1.00 | 32.93 | | C |
| ANISOU | 2089 | CG1 | ILE | A | 335 | 4792 | 4160 | 3559 | 23 | −802 | −480 | C |
| ATOM | 2090 | CG2 | ILE | A | 335 | 7.855 | 122.756 | 60.191 | 1.00 | 26.42 | | C |
| ANISOU | 2090 | CG2 | ILE | A | 335 | 3942 | 3240 | 2855 | −53 | −1103 | −385 | C |
| ATOM | 2091 | CD1 | ILE | A | 335 | 5.242 | 121.688 | 61.778 | 1.00 | 36.96 | | C |
| ANISOU | 2091 | CD1 | ILE | A | 335 | 5498 | 4628 | 3916 | 25 | −759 | −501 | C |
| ATOM | 2092 | N | LEU | A | 336 | 8.266 | 120.829 | 57.066 | 1.00 | 32.98 | | N |
| ANISOU | 2092 | N | LEU | A | 336 | 4390 | 4213 | 3928 | −105 | −922 | −237 | N |
| ATOM | 2093 | CA | LEU | A | 336 | 9.516 | 120.651 | 56.319 | 1.00 | 29.76 | | C |
| ANISOU | 2093 | CA | LEU | A | 336 | 3882 | 3769 | 3655 | −158 | −953 | −173 | C |
| ATOM | 2094 | C | LEU | A | 336 | 9.392 | 121.177 | 54.904 | 1.00 | 30.01 | | C |
| ANISOU | 2094 | C | LEU | A | 336 | 3876 | 3779 | 3745 | −154 | −872 | −148 | C |
| ATOM | 2095 | O | LEU | A | 336 | 10.395 | 121.431 | 54.241 | 1.00 | 27.30 | | O |
| ANISOU | 2095 | O | LEU | A | 336 | 3482 | 3369 | 3520 | −204 | −859 | −107 | O |
| ATOM | 2096 | CB | LEU | A | 336 | 9.916 | 119.177 | 56.280 | 1.00 | 23.51 | | C |
| ANISOU | 2096 | CB | LEU | A | 336 | 3022 | 3026 | 2883 | −174 | −931 | −128 | C |
| ATOM | 2097 | CG | LEU | A | 336 | 10.265 | 118.626 | 57.657 | 1.00 | 25.53 | | C |
| ANISOU | 2097 | CG | LEU | A | 336 | 3363 | 3264 | 3073 | −174 | −1038 | −147 | C |
| ATOM | 2098 | CD1 | LEU | A | 336 | 10.585 | 117.114 | 57.593 | 1.00 | 26.88 | | C |
| ANISOU | 2098 | CD1 | LEU | A | 336 | 3487 | 3476 | 3250 | −181 | −1020 | −103 | C |
| ATOM | 2099 | CD2 | LEU | A | 336 | 11.400 | 119.425 | 58.275 | 1.00 | 25.29 | | C |
| ANISOU | 2099 | CD2 | LEU | A | 336 | 3347 | 3129 | 3134 | −200 | −1211 | −170 | C |
| ATOM | 2100 | N | CYS | A | 337 | 8.153 | 121.339 | 54.449 | 1.00 | 23.17 | | N |
| ANISOU | 2100 | N | CYS | A | 337 | 3049 | 2950 | 2804 | −90 | −816 | −183 | N |
| ATOM | 2101 | CA | CYS | A | 337 | 7.905 | 121.767 | 53.090 | 1.00 | 26.65 | | C |
| ANISOU | 2101 | CA | CYS | A | 337 | 3514 | 3350 | 3262 | −59 | −768 | −167 | C |
| ATOM | 2102 | C | CYS | A | 337 | 7.793 | 123.294 | 53.054 | 1.00 | 31.30 | | C |
| ANISOU | 2102 | C | CYS | A | 337 | 4202 | 3853 | 3839 | −43 | −816 | −204 | C |
| ATOM | 2103 | O | CYS | A | 337 | 6.722 | 123.853 | 53.293 | 1.00 | 23.86 | | O |
| ANISOU | 2103 | O | CYS | A | 337 | 3312 | 2921 | 2834 | 26 | −847 | −277 | O |
| ATOM | 2104 | CB | CYS | A | 337 | 6.642 | 121.107 | 52.554 | 1.00 | 22.54 | | C |
| ANISOU | 2104 | CB | CYS | A | 337 | 2981 | 2890 | 2693 | 18 | −729 | −203 | C |
| ATOM | 2105 | SG | CYS | A | 337 | 6.204 | 121.531 | 50.847 | 1.00 | 32.26 | | S |
| ANISOU | 2105 | SG | CYS | A | 337 | 4304 | 4042 | 3911 | 91 | −721 | −198 | S |
| ATOM | 2106 | N | ILE | A | 338 | 8.909 | 123.954 | 52.781 | 1.00 | 31.64 | | N |
| ANISOU | 2106 | N | ILE | A | 338 | 4260 | 3801 | 3961 | −110 | −815 | −162 | N |
| ATOM | 2107 | CA | ILE | A | 338 | 8.930 | 125.404 | 52.721 | 1.00 | 31.53 | | C |
| ANISOU | 2107 | CA | ILE | A | 338 | 4351 | 3687 | 3942 | −108 | −853 | −189 | C |
| ATOM | 2108 | C | ILE | A | 338 | 8.779 | 125.884 | 51.288 | 1.00 | 30.99 | | C |
| ANISOU | 2108 | C | ILE | A | 338 | 4402 | 3525 | 3848 | −78 | −780 | −160 | C |
| ATOM | 2109 | O | ILE | A | 338 | 9.679 | 125.728 | 50.472 | 1.00 | 25.73 | | O |
| ANISOU | 2109 | O | ILE | A | 338 | 3741 | 2783 | 3252 | −138 | −677 | −94 | O |
| ATOM | 2110 | CB | ILE | A | 338 | 10.210 | 125.955 | 53.305 | 1.00 | 33.45 | | C |
| ANISOU | 2110 | CB | ILE | A | 338 | 4552 | 3849 | 4307 | −204 | −895 | −176 | C |
| ATOM | 2111 | CG1 | ILE | A | 338 | 10.323 | 125.502 | 54.763 | 1.00 | 34.85 | | C |
| ANISOU | 2111 | CG1 | ILE | A | 338 | 4676 | 4091 | 4474 | −210 | −1008 | −213 | C |
| ATOM | 2112 | CG2 | ILE | A | 338 | 10.212 | 127.495 | 53.177 | 1.00 | 34.15 | | C |
| ANISOU | 2112 | CG2 | ILE | A | 338 | 4763 | 3821 | 4392 | −208 | −926 | −203 | C |
| ATOM | 2113 | CD1 | ILE | A | 338 | 11.706 | 125.523 | 55.305 | 1.00 | 35.61 | | C |
| ANISOU | 2113 | CD1 | ILE | A | 338 | 4686 | 4116 | 4730 | −295 | −1086 | −206 | C |
| ATOM | 2114 | N | GLN | A | 339 | 7.624 | 126.469 | 50.994 | 1.00 | 33.91 | | N |
| ANISOU | 2114 | N | GLN | A | 339 | 4884 | 3883 | 4119 | 24 | −833 | −218 | N |
| ATOM | 2115 | CA | GLN | A | 339 | 7.263 | 126.809 | 49.619 | 1.00 | 34.92 | | C |
| ANISOU | 2115 | CA | GLN | A | 339 | 5178 | 3908 | 4182 | 90 | −806 | −204 | C |
| ATOM | 2116 | C | GLN | A | 339 | 7.611 | 128.250 | 49.275 | 1.00 | 36.65 | | C |
| ANISOU | 2116 | C | GLN | A | 339 | 5575 | 3969 | 4380 | 75 | −809 | −200 | C |
| ATOM | 2117 | O | GLN | A | 339 | 7.419 | 128.696 | 48.136 | 1.00 | 41.71 | | O |
| ANISOU | 2117 | O | GLN | A | 339 | 6423 | 4484 | 4942 | 129 | −785 | −184 | O |
| ATOM | 2118 | CB | GLN | A | 339 | 5.777 | 126.534 | 49.384 | 1.00 | 30.21 | | C |
| ANISOU | 2118 | CB | GLN | A | 339 | 4599 | 3363 | 3516 | 227 | −896 | −289 | C |
| ATOM | 2119 | CG | GLN | A | 339 | 5.348 | 125.182 | 49.943 | 1.00 | 30.81 | | C |
| ANISOU | 2119 | CG | GLN | A | 339 | 4487 | 3589 | 3629 | 228 | −880 | −307 | C |
| ATOM | 2120 | CD | GLN | A | 339 | 3.897 | 124.859 | 49.662 | 1.00 | 34.91 | | C |
| ANISOU | 2120 | CD | GLN | A | 339 | 4984 | 4141 | 4139 | 352 | −956 | −408 | C |
| ATOM | 2121 | OE1 | GLN | A | 339 | 3.034 | 125.010 | 50.530 | 1.00 | 46.50 | | O |
| ANISOU | 2121 | OE1 | GLN | A | 339 | 6365 | 5665 | 5635 | 389 | −992 | −504 | O |
| ATOM | 2122 | NE2 | GLN | A | 339 | 3.619 | 124.396 | 48.448 | 1.00 | 34.21 | | N |
| ANISOU | 2122 | NE2 | GLN | A | 339 | 4974 | 3999 | 4025 | 420 | −977 | −397 | N |
| ATOM | 2123 | N | ASP | A | 340 | 8.145 | 128.966 | 50.254 | 1.00 | 30.07 | | N |
| ANISOU | 2123 | N | ASP | A | 340 | 4690 | 3127 | 3609 | 4 | −844 | −216 | N |
| ATOM | 2124 | CA | ASP | A | 340 | 8.458 | 130.375 | 50.073 | 1.00 | 28.44 | | C |
| ANISOU | 2124 | CA | ASP | A | 340 | 4642 | 2768 | 3394 | −18 | −853 | −220 | C |
| ATOM | 2125 | C | ASP | A | 340 | 9.788 | 130.766 | 50.705 | 1.00 | 32.50 | | C |
| ANISOU | 2125 | C | ASP | A | 340 | 5063 | 3226 | 4061 | −161 | −817 | −191 | C |
| ATOM | 2126 | O | ASP | A | 340 | 9.849 | 131.676 | 51.529 | 1.00 | 33.24 | | O |
| ANISOU | 2126 | O | ASP | A | 340 | 5169 | 3288 | 4172 | −178 | −912 | −238 | O |
| ATOM | 2127 | CB | ASP | A | 340 | 7.329 | 131.238 | 50.636 | 1.00 | 28.57 | | C |
| ANISOU | 2127 | CB | ASP | A | 340 | 4733 | 2800 | 3321 | 88 | −999 | −317 | C |
| ATOM | 2128 | CG | ASP | A | 340 | 7.100 | 131.013 | 52.113 | 1.00 | 46.73 | | C |
| ANISOU | 2128 | CG | ASP | A | 340 | 6877 | 5228 | 5649 | 81 | −1076 | −375 | C |
| ATOM | 2129 | OD1 | ASP | A | 340 | 7.515 | 129.955 | 52.646 | 1.00 | 46.83 | | O |
| ANISOU | 2129 | OD1 | ASP | A | 340 | 6735 | 5341 | 5717 | 26 | −1042 | −347 | O |
| ATOM | 2130 | OD2 | ASP | A | 340 | 6.485 | 131.899 | 52.737 | 1.00 | 46.15 | | O |
| ANISOU | 2130 | OD2 | ASP | A | 340 | 6865 | 5141 | 5530 | 137 | −1167 | −451 | O |
| ATOM | 2131 | N | MET | A | 341 | 10.859 | 130.083 | 50.315 | 1.00 | 31.63 | | N |
| ANISOU | 2131 | N | MET | A | 341 | 4849 | 3088 | 4080 | −260 | −687 | −126 | N |
| ATOM | 2132 | CA | MET | A | 341 | 12.169 | 130.421 | 50.844 | 1.00 | 33.56 | | C |
| ANISOU | 2132 | CA | MET | A | 341 | 4967 | 3254 | 4529 | −395 | −664 | −120 | C |
| ATOM | 2133 | C | MET | A | 341 | 12.575 | 131.833 | 50.433 | 1.00 | 36.87 | | C |
| ANISOU | 2133 | C | MET | A | 341 | 5543 | 3481 | 4986 | −452 | −607 | −119 | C |
| ATOM | 2134 | O | MET | A | 341 | 13.388 | 132.467 | 51.094 | 1.00 | 41.03 | | O |
| ANISOU | 2134 | O | MET | A | 341 | 5983 | 3931 | 5674 | −544 | −650 | −148 | O |
| ATOM | 2135 | CB | MET | A | 341 | 13.203 | 129.425 | 50.372 | 1.00 | 40.87 | | C |
| ANISOU | 2135 | CB | MET | A | 341 | 5742 | 4168 | 5619 | −482 | −518 | −65 | C |
| ATOM | 2136 | CG | MET | A | 341 | 12.910 | 128.016 | 50.839 | 1.00 | 49.07 | | C |
| ANISOU | 2136 | CG | MET | A | 341 | 6631 | 5383 | 6630 | −435 | −581 | −64 | C |
| ATOM | 2137 | SD | MET | A | 341 | 14.418 | 127.077 | 51.085 | 1.00 | 47.70 | | S |
| ANISOU | 2137 | SD | MET | A | 341 | 6197 | 5196 | 6732 | −550 | −528 | −47 | S |
| ATOM | 2138 | CE | MET | A | 341 | 13.781 | 125.562 | 51.780 | 1.00 | 27.99 | | C |
| ANISOU | 2138 | CE | MET | A | 341 | 3604 | 2905 | 4126 | −468 | −642 | −52 | C |
| ATOM | 2139 | N | ASN | A | 342 | 11.984 | 132.339 | 49.358 | 1.00 | 32.03 | | N |
| ANISOU | 2139 | N | ASN | A | 342 | 5180 | 2773 | 4220 | −389 | −529 | −94 | N |
| ATOM | 2140 | CA | ASN | A | 342 | 12.301 | 133.689 | 48.902 | 1.00 | 43.26 | | C |
| ANISOU | 2140 | CA | ASN | A | 342 | 6804 | 3990 | 5644 | −437 | −461 | −88 | C |
| ATOM | 2141 | C | ASN | A | 342 | 11.833 | 134.707 | 49.935 | 1.00 | 41.68 | | C |
| ANISOU | 2141 | C | ASN | A | 342 | 6624 | 3806 | 5406 | −400 | −661 | −163 | C |
| ATOM | 2142 | O | ASN | A | 342 | 12.257 | 135.852 | 49.926 | 1.00 | 45.25 | | O |
| ANISOU | 2142 | O | ASN | A | 342 | 7184 | 4100 | 5908 | −463 | −642 | −172 | O |
| ATOM | 2143 | CB | ASN | A | 342 | 11.671 | 133.981 | 47.531 | 1.00 | 45.30 | | C |
| ANISOU | 2143 | CB | ASN | A | 342 | 7390 | 4122 | 5699 | −349 | −366 | −50 | C |
| ATOM | 2144 | CG | ASN | A | 342 | 10.144 | 133.945 | 47.557 | 1.00 | 48.99 | | C |
| ANISOU | 2144 | CG | ASN | A | 342 | 7968 | 4694 | 5951 | −160 | −567 | −108 | C |
| ATOM | 2145 | OD1 | ASN | A | 342 | 9.530 | 133.156 | 48.288 | 1.00 | 50.31 | | O |
| ANISOU | 2145 | OD1 | ASN | A | 342 | 7943 | 5057 | 6117 | −99 | −691 | −152 | O |
| ATOM | 2146 | ND2 | ASN | A | 342 | 9.525 | 134.819 | 46.770 | 1.00 | 45.31 | | N |
| ANISOU | 2146 | ND2 | ASN | A | 342 | 7818 | 4077 | 5318 | −67 | −597 | −118 | N |
| ATOM | 2147 | N | ASN | A | 343 | 10.971 | 134.255 | 50.840 | 1.00 | 38.33 | | N |
| ANISOU | 2147 | N | ASN | A | 343 | 6100 | 3563 | 4900 | −303 | −834 | −220 | N |
| ATOM | 2148 | CA | ASN | A | 343 | 10.391 | 135.089 | 51.875 | 1.00 | 33.05 | | C |
| ANISOU | 2148 | CA | ASN | A | 343 | 5462 | 2924 | 4173 | −247 | −1013 | −298 | C |
| ATOM | 2149 | C | ASN | A | 343 | 11.012 | 134.819 | 53.267 | 1.00 | 35.24 | | C |
| ANISOU | 2149 | C | ASN | A | 343 | 5539 | 3276 | 4577 | −312 | −1122 | −334 | C |
| ATOM | 2150 | O | ASN | A | 343 | 10.461 | 134.061 | 54.071 | 1.00 | 36.16 | | O |
| ANISOU | 2150 | O | ASN | A | 343 | 5566 | 3544 | 4631 | −249 | −1206 | −367 | O |
| ATOM | 2151 | CB | ASN | A | 343 | 8.877 | 134.861 | 51.895 | 1.00 | 32.96 | | C |
| ANISOU | 2151 | CB | ASN | A | 343 | 5516 | 3028 | 3979 | −80 | −1108 | −355 | C |
| ATOM | 2152 | CG | ASN | A | 343 | 8.134 | 135.944 | 52.640 | 1.00 | 36.25 | | C |
| ANISOU | 2152 | CG | ASN | A | 343 | 6028 | 3429 | 4316 | −1 | −1253 | −442 | C |
| ATOM | 2153 | OD1 | ASN | A | 343 | 8.677 | 136.580 | 53.544 | 1.00 | 32.41 | | O |
| ANISOU | 2153 | OD1 | ASN | A | 343 | 5516 | 2906 | 3893 | −64 | −1320 | −465 | O |
| ATOM | 2154 | ND2 | ASN | A | 343 | 6.883 | 136.166 | 52.261 | 1.00 | 37.07 | | N |
| ANISOU | 2154 | ND2 | ASN | A | 343 | 6242 | 3547 | 4295 | 145 | −1317 | −501 | N |
| ATOM | 2155 | N | ALA | A | 344 | 12.168 | 135.426 | 53.530 | 1.00 | 28.85 | | N |
| ANISOU | 2155 | N | ALA | A | 344 | 4950 | 3020 | 2992 | −355 | −1335 | −854 | N |
| ATOM | 2156 | CA | ALA | A | 344 | 12.940 | 135.181 | 54.753 | 1.00 | 30.78 | | C |
| ANISOU | 2156 | CA | ALA | A | 344 | 5315 | 3250 | 3131 | −352 | −1404 | −843 | C |
| ATOM | 2157 | C | ALA | A | 344 | 12.169 | 135.469 | 56.037 | 1.00 | 35.31 | | C |
| ANISOU | 2157 | C | ALA | A | 344 | 6274 | 3700 | 3442 | −154 | −1390 | −880 | C |
| ATOM | 2158 | O | ALA | A | 344 | 12.292 | 134.740 | 57.023 | 1.00 | 39.02 | | O |
| ANISOU | 2158 | O | ALA | A | 344 | 6827 | 4179 | 3820 | −106 | −1410 | −870 | O |
| ATOM | 2159 | CB | ALA | A | 344 | 14.215 | 135.999 | 54.734 | 1.00 | 27.93 | | C |
| ANISOU | 2159 | CB | ALA | A | 344 | 4947 | 2874 | 2790 | −482 | −1493 | −799 | C |
| ATOM | 2160 | N | TYR | A | 345 | 11.380 | 136.531 | 56.020 | 1.00 | 36.87 | | N |
| ANISOU | 2160 | N | TYR | A | 345 | 6747 | 3770 | 3491 | 0 | −1319 | −911 | N |
| ATOM | 2161 | CA | TYR | A | 345 | 10.493 | 136.836 | 57.127 | 1.00 | 38.01 | | C |
| ANISOU | 2161 | CA | TYR | A | 345 | 7344 | 3771 | 3328 | 308 | −1183 | −920 | C |
| ATOM | 2162 | C | TYR | A | 345 | 9.515 | 135.693 | 57.419 | 1.00 | 37.61 | | C |
| ANISOU | 2162 | C | TYR | A | 345 | 7001 | 3891 | 3398 | 494 | −949 | −751 | C |
| ATOM | 2163 | O | TYR | A | 345 | 9.313 | 135.349 | 58.577 | 1.00 | 44.75 | | O |
| ANISOU | 2163 | O | TYR | A | 345 | 8098 | 4763 | 4144 | 673 | −844 | −704 | O |
| ATOM | 2164 | CB | TYR | A | 345 | 9.714 | 138.116 | 56.843 | 1.00 | 41.36 | | C |
| ANISOU | 2164 | CB | TYR | A | 345 | 8041 | 4051 | 3622 | 512 | −1026 | −906 | C |
| ATOM | 2165 | CG | TYR | A | 345 | 8.590 | 138.389 | 57.817 | 1.00 | 42.90 | | C |
| ANISOU | 2165 | CG | TYR | A | 345 | 8534 | 4157 | 3610 | 940 | −677 | −756 | C |
| ATOM | 2166 | CD1 | TYR | A | 345 | 8.835 | 138.999 | 59.034 | 1.00 | 39.27 | | C |
| ANISOU | 2166 | CD1 | TYR | A | 345 | 8685 | 3446 | 2792 | 1084 | −651 | −804 | C |
| ATOM | 2167 | CD2 | TYR | A | 345 | 7.276 | 138.038 | 57.511 | 1.00 | 43.34 | | C |
| ANISOU | 2167 | CD2 | TYR | A | 345 | 8233 | 4381 | 3852 | 1190 | −366 | −490 | C |
| ATOM | 2168 | CE1 | TYR | A | 345 | 7.807 | 139.254 | 59.918 | 1.00 | 51.75 | | C |
| ANISOU | 2168 | CE1 | TYR | A | 345 | 10643 | 4899 | 4121 | 1551 | −270 | −665 | C |
| ATOM | 2169 | CE2 | TYR | A | 345 | 6.239 | 138.289 | 58.392 | 1.00 | 46.95 | | C |
| ANISOU | 2169 | CE2 | TYR | A | 345 | 8918 | 4777 | 4145 | 1636 | 10 | −270 | C |
| ATOM | 2170 | CZ | TYR | A | 345 | 6.511 | 138.902 | 59.595 | 1.00 | 55.18 | | C |
| ANISOU | 2170 | CZ | TYR | A | 345 | 10650 | 5535 | 4779 | 1849 | 91 | −370 | C |
| ATOM | 2171 | OH | TYR | A | 345 | 5.489 | 139.164 | 60.482 | 1.00 | 59.86 | | O |
| ANISOU | 2171 | OH | TYR | A | 345 | 11538 | 6032 | 5176 | 2357 | 530 | −129 | O |
| ATOM | 2172 | N | ASP | A | 346 | 8.889 | 135.118 | 56.394 | 1.00 | 34.55 | | N |
| ANISOU | 2172 | N | ASP | A | 346 | 6175 | 3672 | 3279 | 434 | −882 | −630 | N |
| ATOM | 2173 | CA | ASP | A | 346 | 7.899 | 134.076 | 56.664 | 1.00 | 36.30 | | C |
| ANISOU | 2173 | CA | ASP | A | 346 | 6119 | 4055 | 3619 | 564 | −701 | −405 | C |
| ATOM | 2174 | C | ASP | A | 346 | 8.595 | 132.791 | 57.093 | 1.00 | 35.21 | | C |
| ANISOU | 2174 | C | ASP | A | 346 | 5861 | 3992 | 3524 | 420 | −814 | −459 | C |
| ATOM | 2175 | O | ASP | A | 346 | 8.083 | 132.055 | 57.921 | 1.00 | 36.81 | | O |
| ANISOU | 2175 | O | ASP | A | 346 | 6016 | 4266 | 3703 | 568 | −686 | −331 | O |
| ATOM | 2176 | CB | ASP | A | 346 | 6.992 | 133.796 | 55.471 | 1.00 | 35.56 | | C |
| ANISOU | 2176 | CB | ASP | A | 346 | 5640 | 4097 | 3774 | 474 | −663 | −206 | C |
| ATOM | 2177 | CG | ASP | A | 346 | 5.782 | 132.955 | 55.863 | 1.00 | 44.07 | | C |
| ANISOU | 2177 | CG | ASP | A | 346 | 6457 | 5335 | 4954 | 621 | −485 | 127 | C |
| ATOM | 2178 | OD1 | ASP | A | 346 | 5.167 | 133.261 | 56.909 | 1.00 | 52.21 | | O |
| ANISOU | 2178 | OD1 | ASP | A | 346 | 7628 | 6355 | 5856 | 960 | −245 | 275 | O |
| ATOM | 2179 | OD2 | ASP | A | 346 | 5.451 | 131.981 | 55.157 | 1.00 | 44.79 | | O |
| ANISOU | 2179 | OD2 | ASP | A | 346 | 6241 | 5544 | 5231 | 398 | −585 | 264 | O |
| ATOM | 2180 | N | VAL | A | 347 | 9.774 | 132.549 | 56.547 | 1.00 | 27.89 | | N |
| ANISOU | 2180 | N | VAL | A | 347 | 4887 | 3050 | 2661 | 157 | −1030 | −617 | N |
| ATOM | 2181 | CA | VAL | A | 347 | 10.566 | 131.396 | 56.936 | 1.00 | 30.24 | | C |
| ANISOU | 2181 | CA | VAL | A | 347 | 5086 | 3407 | 2996 | 46 | −1113 | −644 | C |
| ATOM | 2182 | C | VAL | A | 347 | 10.924 | 131.491 | 58.415 | 1.00 | 34.80 | | C |
| ANISOU | 2182 | C | VAL | A | 347 | 5942 | 3923 | 3359 | 170 | −1128 | −678 | C |
| ATOM | 2183 | O | VAL | A | 347 | 10.728 | 130.549 | 59.187 | 1.00 | 39.65 | | O |
| ANISOU | 2183 | O | VAL | A | 347 | 6496 | 4607 | 3961 | 251 | −1053 | −608 | O |
| ATOM | 2184 | CB | VAL | A | 347 | 11.842 | 131.276 | 56.065 | 1.00 | 34.71 | | C |
| ANISOU | 2184 | CB | VAL | A | 347 | 5559 | 3960 | 3670 | −201 | −1292 | −738 | C |
| ATOM | 2185 | CG1 | VAL | A | 347 | 12.846 | 130.341 | 56.698 | 1.00 | 34.40 | | C |
| ANISOU | 2185 | CG1 | VAL | A | 347 | 5471 | 3966 | 3636 | −263 | −1363 | −725 | C |
| ATOM | 2186 | CG2 | VAL | A | 347 | 11.467 | 130.804 | 54.654 | 1.00 | 24.57 | | C |
| ANISOU | 2186 | CG2 | VAL | A | 347 | 4060 | 2711 | 2565 | −320 | −1252 | −693 | C |
| ATOM | 2187 | N | ASN | A | 348 | 11.412 | 132.655 | 58.821 | 1.00 | 38.32 | | N |
| ANISOU | 2187 | N | ASN | A | 348 | 6742 | 4211 | 3608 | 168 | −1239 | −778 | N |
| ATOM | 2188 | CA | ASN | A | 348 | 11.762 | 132.865 | 60.209 | 1.00 | 36.70 | | C |
| ANISOU | 2188 | CA | ASN | A | 348 | 6926 | 3884 | 3134 | 243 | −1297 | −809 | C |
| ATOM | 2189 | C | ASN | A | 348 | 10.559 | 132.693 | 61.125 | 1.00 | 35.13 | | C |
| ANISOU | 2189 | C | ASN | A | 348 | 6876 | 3671 | 2800 | 587 | −1004 | −705 | C |
| ATOM | 2190 | O | ASN | A | 348 | 10.673 | 132.152 | 62.219 | 1.00 | 42.23 | | O |
| ANISOU | 2190 | O | ASN | A | 348 | 7923 | 4556 | 3568 | 664 | −987 | −683 | O |
| ATOM | 2191 | CB | ASN | A | 348 | 12.384 | 134.241 | 60.384 | 1.00 | 46.51 | | C |
| ANISOU | 2191 | CB | ASN | A | 348 | 8470 | 4942 | 4259 | 148 | −1409 | −837 | C |
| ATOM | 2192 | CG | ASN | A | 348 | 12.666 | 134.556 | 61.817 | 1.00 | 49.35 | | C |
| ANISOU | 2192 | CG | ASN | A | 348 | 9239 | 5133 | 4380 | 198 | −1439 | −802 | C |
| ATOM | 2193 | OD1 | ASN | A | 348 | 12.094 | 135.487 | 62.375 | 1.00 | 53.39 | | O |
| ANISOU | 2193 | OD1 | ASN | A | 348 | 10194 | 5435 | 4657 | 392 | −1317 | −796 | O |
| ATOM | 2194 | ND2 | ASN | A | 348 | 13.532 | 133.762 | 62.439 | 1.00 | 50.20 | | N |
| ANISOU | 2194 | ND2 | ASN | A | 348 | 9233 | 5307 | 4533 | 36 | −1589 | −757 | N |
| ATOM | 2195 | N | LYS | A | 349 | 9.399 | 133.135 | 60.666 | 1.00 | 33.92 | | N |
| ANISOU | 2195 | N | LYS | A | 349 | 6656 | 3536 | 2695 | 803 | −760 | −594 | N |
| ATOM | 2196 | CA | LYS | A | 349 | 8.178 | 132.925 | 61.424 | 1.00 | 42.57 | | C |
| ANISOU | 2196 | CA | LYS | A | 349 | 7791 | 4661 | 3721 | 1166 | −429 | −391 | C |
| ATOM | 2197 | C | LYS | A | 349 | 7.902 | 131.435 | 61.595 | 1.00 | 43.94 | | C |
| ANISOU | 2197 | C | LYS | A | 349 | 7556 | 5050 | 4090 | 1131 | −391 | −260 | C |
| ATOM | 2198 | O | LYS | A | 349 | 7.523 | 130.999 | 62.672 | 1.00 | 53.19 | | O |
| ANISOU | 2198 | O | LYS | A | 349 | 8844 | 6224 | 5142 | 1346 | −234 | −162 | O |
| ATOM | 2199 | CB | LYS | A | 349 | 6.994 | 133.608 | 60.745 | 1.00 | 44.46 | | C |
| ANISOU | 2199 | CB | LYS | A | 349 | 7909 | 4933 | 4050 | 1383 | −180 | −196 | C |
| ATOM | 2200 | CG | LYS | A | 349 | 5.649 | 133.091 | 61.222 | 1.00 | 53.05 | | C |
| ANISOU | 2200 | CG | LYS | A | 349 | 8784 | 6160 | 5211 | 1717 | 162 | 153 | C |
| ATOM | 2201 | CD | LYS | A | 349 | 4.657 | 134.207 | 61.449 | 1.00 | 55.60 | | C |
| ANISOU | 2201 | CD | LYS | A | 349 | 9358 | 6375 | 5393 | 2141 | 520 | 368 | C |
| ATOM | 2202 | CE | LYS | A | 349 | 4.627 | 135.135 | 60.256 | 1.00 | 52.26 | | C |
| ANISOU | 2202 | CE | LYS | A | 349 | 8863 | 5924 | 5071 | 2022 | 445 | 329 | C |
| ATOM | 2203 | NZ | LYS | A | 349 | 3.603 | 136.169 | 60.443 | 1.00 | 50.78 | | N |
| ANISOU | 2203 | NZ | LYS | A | 349 | 8885 | 5644 | 4767 | 2473 | 838 | 594 | N |
| ATOM | 2204 | N | ARG | A | 350 | 8.092 | 130.649 | 60.538 | 1.00 | 48.97 | | N |
| ANISOU | 2204 | N | ARG | A | 350 | 7770 | 5839 | 4999 | 864 | −527 | −253 | N |
| ATOM | 2205 | CA | ARG | A | 350 | 7.888 | 129.210 | 60.650 | 1.00 | 50.28 | | C |
| ANISOU | 2205 | CA | ARG | A | 350 | 7623 | 6166 | 5315 | 796 | −518 | −138 | C |
| ATOM | 2206 | C | ARG | A | 350 | 8.819 | 128.616 | 61.715 | 1.00 | 50.75 | | C |
| ANISOU | 2206 | C | ARG | A | 350 | 7849 | 6191 | 5243 | 768 | −613 | −261 | C |
| ATOM | 2207 | O | ARG | A | 350 | 8.377 | 127.878 | 62.597 | 1.00 | 53.14 | | O |
| ANISOU | 2207 | O | ARG | A | 350 | 8124 | 6558 | 5509 | 915 | −490 | −148 | O |
| ATOM | 2208 | CB | ARG | A | 350 | 8.093 | 128.508 | 59.303 | 1.00 | 46.82 | | C |
| ANISOU | 2208 | CB | ARG | A | 350 | 6865 | 5812 | 5113 | 496 | −664 | −140 | C |
| ATOM | 2209 | CG | ARG | A | 350 | 7.934 | 126.964 | 59.405 | 1.00 | 37.19 | | C |
| ANISOU | 2209 | CG | ARG | A | 350 | 5421 | 4707 | 4001 | 402 | −672 | −28 | C |
| ATOM | 2210 | CD | ARG | A | 350 | 8.049 | 126.268 | 58.055 | 1.00 | 29.71 | | C |
| ANISOU | 2210 | CD | ARG | A | 350 | 4303 | 3770 | 3215 | 118 | −795 | −16 | C |
| ATOM | 2211 | NE | ARG | A | 350 | 7.219 | 126.920 | 57.044 | 1.00 | 33.78 | | N |
| ANISOU | 2211 | NE | ARG | A | 350 | 4720 | 4291 | 3823 | 54 | −802 | 108 | N |
| ATOM | 2212 | CZ | ARG | A | 350 | 6.661 | 126.296 | 56.014 | 1.00 | 43.05 | | C |
| ANISOU | 2212 | CZ | ARG | A | 350 | 5756 | 5485 | 5117 | −172 | −891 | 260 | C |
| ATOM | 2213 | NH1 | ARG | A | 350 | 6.815 | 124.983 | 55.872 | 1.00 | 39.16 | | N |
| ANISOU | 2213 | NH1 | ARG | A | 350 | 5257 | 4983 | 4640 | −338 | −962 | 294 | N |
| ATOM | 2214 | NH2 | ARG | A | 350 | 5.931 | 126.979 | 55.136 | 1.00 | 45.69 | | N |
| ANISOU | 2214 | NH2 | ARG | A | 350 | 5999 | 5828 | 5534 | −246 | −922 | 398 | N |
| ATOM | 2215 | N | LEU | A | 351 | 10.099 | 128.960 | 61.633 | 1.00 | 47.88 | | N |
| ANISOU | 2215 | N | LEU | A | 351 | 7634 | 5737 | 4820 | 570 | −840 | −450 | N |
| ATOM | 2216 | CA | LEU | A | 351 | 11.090 | 128.536 | 62.611 | 1.00 | 44.36 | | C |
| ANISOU | 2216 | CA | LEU | A | 351 | 7339 | 5259 | 4256 | 499 | −982 | −518 | C |
| ATOM | 2217 | C | LEU | A | 351 | 10.645 | 128.795 | 64.043 | 1.00 | 50.15 | | C |
| ANISOU | 2217 | C | LEU | A | 351 | 8450 | 5889 | 4716 | 746 | −863 | −489 | C |
| ATOM | 2218 | O | LEU | A | 351 | 10.656 | 127.896 | 64.873 | 1.00 | 51.30 | | O |
| ANISOU | 2218 | O | LEU | A | 351 | 8560 | 6095 | 4836 | 802 | −825 | −437 | O |
| ATOM | 2219 | CB | LEU | A | 351 | 12.401 | 129.256 | 62.354 | 1.00 | 48.81 | | C |
| ANISOU | 2219 | CB | LEU | A | 351 | 8045 | 5726 | 4773 | 258 | −1261 | −632 | C |
| ATOM | 2220 | CG | LEU | A | 351 | 13.255 | 128.673 | 61.233 | 1.00 | 49.62 | | C |
| ANISOU | 2220 | CG | LEU | A | 351 | 7787 | 5936 | 5131 | 28 | −1372 | −622 | C |
| ATOM | 2221 | CD1 | LEU | A | 351 | 14.677 | 129.206 | 61.346 | 1.00 | 53.66 | | C |
| ANISOU | 2221 | CD1 | LEU | A | 351 | 8392 | 6392 | 5603 | −198 | −1658 | −627 | C |
| ATOM | 2222 | CD2 | LEU | A | 351 | 13.228 | 127.149 | 61.238 | 1.00 | 47.21 | | C |
| ANISOU | 2222 | CD2 | LEU | A | 351 | 7195 | 5767 | 4975 | 38 | −1271 | −537 | C |
| ATOM | 2223 | N | LYS | A | 352 | 10.232 | 130.027 | 64.329 | 1.00 | 58.16 | | N |
| ANISOU | 2223 | N | LYS | A | 352 | 9872 | 6723 | 5503 | 918 | −779 | −517 | N |
| ATOM | 2224 | CA | LYS | A | 352 | 9.799 | 130.373 | 65.679 | 1.00 | 59.32 | | C |
| ANISOU | 2224 | CA | LYS | A | 352 | 10512 | 6703 | 5324 | 1202 | −618 | −484 | C |
| ATOM | 2225 | C | LYS | A | 352 | 8.516 | 129.640 | 66.059 | 1.00 | 57.02 | | C |
| ANISOU | 2225 | C | LYS | A | 352 | 9996 | 6554 | 5116 | 1529 | −261 | −260 | C |
| ATOM | 2226 | O | LYS | A | 352 | 8.386 | 129.157 | 67.187 | 1.00 | 56.71 | | O |
| ANISOU | 2226 | O | LYS | A | 352 | 10141 | 6484 | 4920 | 1691 | −160 | −210 | O |
| ATOM | 2227 | CB | LYS | A | 352 | 9.624 | 131.887 | 65.823 | 1.00 | 66.01 | | C |
| ANISOU | 2227 | CB | LYS | A | 352 | 11939 | 7272 | 5869 | 1347 | −565 | −547 | C |
| ATOM | 2228 | CG | LYS | A | 352 | 10.925 | 132.640 | 65.537 | 1.00 | 76.64 | | C |
| ANISOU | 2228 | CG | LYS | A | 352 | 13449 | 8476 | 7193 | 961 | −951 | −692 | C |
| ATOM | 2229 | CD | LYS | A | 352 | 11.912 | 132.538 | 66.710 | 1.00 | 86.71 | | C |
| ANISOU | 2229 | CD | LYS | A | 352 | 14946 | 9615 | 8386 | 757 | −1167 | −674 | C |
| ATOM | 2230 | CE | LYS | A | 352 | 13.361 | 132.649 | 66.230 | 1.00 | 87.34 | | C |
| ANISOU | 2230 | CE | LYS | A | 352 | 14762 | 9748 | 8675 | 309 | −1532 | −672 | C |
| ATOM | 2231 | NZ | LYS | A | 352 | 14.311 | 133.068 | 67.294 | 1.00 | 88.85 | | N |
| ANISOU | 2231 | NZ | LYS | A | 352 | 15288 | 9733 | 8737 | 96 | −1761 | −604 | N |
| ATOM | 2232 | N | MET | A | 353 | 7.586 | 129.527 | 65.116 | 1.00 | 52.58 | | N |
| ANISOU | 2232 | N | MET | A | 353 | 9017 | 6153 | 4807 | 1599 | −96 | −90 | N |
| ATOM | 2233 | CA | MET | A | 353 | 6.353 | 128.782 | 65.373 | 1.00 | 54.90 | | C |
| ANISOU | 2233 | CA | MET | A | 353 | 9003 | 6623 | 5235 | 1849 | 193 | 215 | C |
| ATOM | 2234 | C | MET | A | 353 | 6.662 | 127.329 | 65.704 | 1.00 | 55.75 | | C |
| ANISOU | 2234 | C | MET | A | 353 | 8826 | 6886 | 5471 | 1689 | 83 | 225 | C |
| ATOM | 2235 | O | MET | A | 353 | 5.998 | 126.715 | 66.545 | 1.00 | 58.12 | | O |
| ANISOU | 2235 | O | MET | A | 353 | 9080 | 7260 | 5744 | 1912 | 283 | 417 | O |
| ATOM | 2236 | CB | MET | A | 353 | 5.394 | 128.839 | 64.181 | 1.00 | 56.86 | | C |
| ANISOU | 2236 | CB | MET | A | 353 | 8804 | 7034 | 5765 | 1833 | 284 | 451 | C |
| ATOM | 2237 | CG | MET | A | 353 | 4.808 | 130.211 | 63.905 | 1.00 | 64.88 | | C |
| ANISOU | 2237 | CG | MET | A | 353 | 10037 | 7930 | 6683 | 2079 | 483 | 539 | C |
| ATOM | 2238 | SD | MET | A | 353 | 3.368 | 130.165 | 62.816 | 1.00 | 82.52 | | S |
| ANISOU | 2238 | SD | MET | A | 353 | 11694 | 10403 | 9258 | 2138 | 651 | 989 | S |
| ATOM | 2239 | CE | MET | A | 353 | 2.045 | 130.194 | 64.036 | 1.00 | 46.85 | | C |
| ANISOU | 2239 | CE | MET | A | 353 | 7217 | 5936 | 4649 | 2722 | 1156 | 1459 | C |
| ATOM | 2240 | N | THR | A | 354 | 7.675 | 126.784 | 65.041 | 1.00 | 47.55 | | N |
| ANISOU | 2240 | N | THR | A | 354 | 7609 | 5892 | 4568 | 1328 | −207 | 44 | N |
| ATOM | 2241 | CA | THR | A | 354 | 8.039 | 125.392 | 65.238 | 1.00 | 45.19 | | C |
| ANISOU | 2241 | CA | THR | A | 354 | 7063 | 5719 | 4388 | 1179 | −297 | 55 | C |
| ATOM | 2242 | C | THR | A | 354 | 8.718 | 125.193 | 66.591 | 1.00 | 50.47 | | C |
| ANISOU | 2242 | C | THR | A | 354 | 8038 | 6303 | 4834 | 1247 | −339 | −42 | C |
| ATOM | 2243 | O | THR | A | 354 | 8.494 | 124.175 | 67.252 | 1.00 | 54.83 | | O |
| ANISOU | 2243 | O | THR | A | 354 | 8470 | 6951 | 5411 | 1311 | −268 | 54 | O |
| ATOM | 2244 | CB | THR | A | 354 | 8.946 | 124.897 | 64.096 | 1.00 | 42.66 | | C |
| ANISOU | 2244 | CB | THR | A | 354 | 6516 | 5438 | 4253 | 838 | −527 | −69 | C |
| ATOM | 2245 | OG1 | THR | A | 354 | 8.215 | 124.971 | 62.868 | 1.00 | 42.54 | | O |
| ANISOU | 2245 | OG1 | THR | A | 354 | 6263 | 5482 | 4418 | 755 | −499 | 40 | O |
| ATOM | 2246 | CG2 | THR | A | 354 | 9.354 | 123.460 | 64.304 | 1.00 | 43.61 | | C |
| ANISOU | 2246 | CG2 | THR | A | 354 | 6452 | 5653 | 4465 | 724 | −578 | −45 | C |
| ATOM | 2247 | N | ASN | A | 355 | 9.520 | 126.167 | 67.018 | 1.00 | 56.79 | | N |
| ANISOU | 2247 | N | ASN | A | 355 | 9261 | 6913 | 5403 | 1210 | −479 | −208 | N |
| ATOM | 2248 | CA | ASN | A | 355 | 10.182 | 126.085 | 68.322 | 1.00 | 62.25 | | C |
| ANISOU | 2248 | CA | ASN | A | 355 | 10323 | 7488 | 5842 | 1221 | −578 | −276 | C |
| ATOM | 2249 | C | ASN | A | 355 | 9.146 | 126.087 | 69.454 | 1.00 | 66.26 | | C |
| ANISOU | 2249 | C | ASN | A | 355 | 11102 | 7934 | 6142 | 1608 | −267 | −145 | C |
| ATOM | 2250 | O | ASN | A | 355 | 9.247 | 125.314 | 70.406 | 1.00 | 61.59 | | O |
| ANISOU | 2250 | O | ASN | A | 355 | 10559 | 7369 | 5474 | 1661 | −248 | −111 | O |
| ATOM | 2251 | CB | ASN | A | 355 | 11.185 | 127.239 | 68.497 | 1.00 | 63.37 | | C |
| ANISOU | 2251 | CB | ASN | A | 355 | 10929 | 7402 | 5745 | 1043 | −850 | −430 | C |
| ATOM | 2252 | CG | ASN | A | 355 | 11.967 | 127.156 | 69.806 | 1.00 | 70.25 | | C |
| ANISOU | 2252 | CG | ASN | A | 355 | 12219 | 8133 | 6340 | 959 | −1046 | −466 | C |
| ATOM | 2253 | OD1 | ASN | A | 355 | 11.480 | 127.526 | 70.875 | 1.00 | 76.75 | | O |
| ANISOU | 2253 | OD1 | ASN | A | 355 | 13548 | 8767 | 6846 | 1197 | −902 | −456 | O |
| ATOM | 2254 | ND2 | ASN | A | 355 | 13.184 | 126.632 | 69.721 | 1.00 | 69.62 | | N |
| ANISOU | 2254 | ND2 | ASN | A | 355 | 11925 | 8142 | 6387 | 628 | −1361 | −466 | N |
| ATOM | 2255 | N | GLU | A | 356 | 8.118 | 126.916 | 69.323 | 1.00 | 71.67 | | N |
| ANISOU | 2255 | N | GLU | A | 356 | 11934 | 8547 | 6749 | 1906 | 13 | −32 | N |
| ATOM | 2256 | CA | GLU | A | 356 | 7.056 | 126.953 | 70.326 | 1.00 | 77.63 | | C |
| ANISOU | 2256 | CA | GLU | A | 356 | 12923 | 9249 | 7322 | 2351 | 394 | 171 | C |
| ATOM | 2257 | C | GLU | A | 356 | 6.320 | 125.619 | 70.394 | 1.00 | 75.25 | | C |
| ANISOU | 2257 | C | GLU | A | 356 | 12077 | 9227 | 7289 | 2422 | 543 | 410 | C |
| ATOM | 2258 | O | GLU | A | 356 | 6.165 | 125.041 | 71.473 | 1.00 | 78.24 | | O |
| ANISOU | 2258 | O | GLU | A | 356 | 12588 | 9601 | 7541 | 2593 | 664 | 482 | O |
| ATOM | 2259 | CB | GLU | A | 356 | 6.077 | 128.096 | 70.039 | 1.00 | 85.09 | | C |
| ANISOU | 2259 | CB | GLU | A | 356 | 14065 | 10087 | 8177 | 2695 | 715 | 326 | C |
| ATOM | 2260 | CG | GLU | A | 356 | 6.743 | 129.466 | 69.920 | 1.00 | 93.57 | | C |
| ANISOU | 2260 | CG | GLU | A | 356 | 15734 | 10856 | 8962 | 2620 | 566 | 95 | C |
| ATOM | 2261 | CD | GLU | A | 356 | 5.807 | 130.546 | 69.400 | 1.00 | 99.70 | | C |
| ANISOU | 2261 | CD | GLU | A | 356 | 16621 | 11553 | 9707 | 2938 | 883 | 254 | C |
| ATOM | 2262 | OE1 | GLU | A | 356 | 4.582 | 130.304 | 69.356 | 1.00 | 101.63 | | O |
| ANISOU | 2262 | OE1 | GLU | A | 356 | 16542 | 11961 | 10110 | 3286 | 1267 | 600 | O |
| ATOM | 2263 | OE2 | GLU | A | 356 | 6.296 | 131.640 | 69.039 | 1.00 | 100.88 | | O |
| ANISOU | 2263 | OE2 | GLU | A | 356 | 17166 | 11484 | 9681 | 2836 | 743 | 73 | O |
| ATOM | 2264 | N | SER | A | 357 | 5.880 | 125.131 | 69.238 | 1.00 | 70.89 | | N |
| ANISOU | 2264 | N | SER | A | 357 | 10952 | 8897 | 7086 | 2261 | 507 | 540 | N |
| ATOM | 2265 | CA | SER | A | 357 | 5.070 | 123.916 | 69.157 | 1.00 | 65.90 | | C |
| ANISOU | 2265 | CA | SER | A | 357 | 9818 | 8513 | 6706 | 2273 | 604 | 820 | C |
| ATOM | 2266 | C | SER | A | 357 | 5.787 | 122.628 | 69.579 | 1.00 | 63.85 | | C |
| ANISOU | 2266 | C | SER | A | 357 | 9434 | 8332 | 6495 | 2055 | 414 | 705 | C |
| ATOM | 2267 | O | SER | A | 357 | 5.183 | 121.750 | 70.196 | 1.00 | 63.87 | | O |
| ANISOU | 2267 | O | SER | A | 357 | 9263 | 8457 | 6548 | 2183 | 550 | 914 | O |
| ATOM | 2268 | CB | SER | A | 357 | 4.550 | 123.737 | 67.731 | 1.00 | 61.13 | | C |
| ANISOU | 2268 | CB | SER | A | 357 | 8737 | 8071 | 6417 | 2055 | 518 | 974 | C |
| ATOM | 2269 | OG | SER | A | 357 | 3.859 | 124.892 | 67.298 | 1.00 | 67.63 | | O |
| ANISOU | 2269 | OG | SER | A | 357 | 9619 | 8849 | 7229 | 2254 | 697 | 1119 | O |
| ATOM | 2270 | N | PHE | A | 358 | 7.068 | 122.502 | 69.256 | 1.00 | 59.51 | | N |
| ANISOU | 2270 | N | PHE | A | 358 | 8951 | 7719 | 5940 | 1744 | 116 | 418 | N |
| ATOM | 2271 | CA | PHE | A | 358 | 7.682 | 121.184 | 69.350 | 1.00 | 56.28 | | C |
| ANISOU | 2271 | CA | PHE | A | 358 | 8324 | 7415 | 5646 | 1533 | −36 | 372 | C |
| ATOM | 2272 | C | PHE | A | 358 | 8.980 | 121.099 | 70.163 | 1.00 | 52.39 | | C |
| ANISOU | 2272 | C | PHE | A | 358 | 8102 | 6820 | 4985 | 1426 | −225 | 167 | C |
| ATOM | 2273 | O | PHE | A | 358 | 9.595 | 120.037 | 70.228 | 1.00 | 52.90 | | O |
| ANISOU | 2273 | O | PHE | A | 358 | 7982 | 6968 | 5149 | 1269 | −335 | 147 | O |
| ATOM | 2274 | CB | PHE | A | 358 | 7.900 | 120.643 | 67.934 | 1.00 | 55.73 | | C |
| ANISOU | 2274 | CB | PHE | A | 358 | 7916 | 7429 | 5830 | 1233 | −190 | 357 | C |
| ATOM | 2275 | CG | PHE | A | 358 | 6.619 | 120.475 | 67.158 | 1.00 | 61.82 | | C |
| ANISOU | 2275 | CG | PHE | A | 358 | 8397 | 8314 | 6779 | 1246 | −85 | 621 | C |
| ATOM | 2276 | CD1 | PHE | A | 358 | 5.609 | 119.641 | 67.630 | 1.00 | 62.26 | | C |
| ANISOU | 2276 | CD1 | PHE | A | 358 | 8242 | 8507 | 6907 | 1354 | 47 | 911 | C |
| ATOM | 2277 | CD2 | PHE | A | 358 | 6.412 | 121.159 | 65.966 | 1.00 | 63.83 | | C |
| ANISOU | 2277 | CD2 | PHE | A | 358 | 8572 | 8546 | 7134 | 1126 | −141 | 624 | C |
| ATOM | 2278 | CE1 | PHE | A | 358 | 4.418 | 119.492 | 66.925 | 1.00 | 64.43 | | C |
| ANISOU | 2278 | CE1 | PHE | A | 358 | 8213 | 8904 | 7362 | 1313 | 90 | 1245 | C |
| ATOM | 2279 | CE2 | PHE | A | 358 | 5.223 | 121.009 | 65.255 | 1.00 | 63.54 | | C |
| ANISOU | 2279 | CE2 | PHE | A | 358 | 8255 | 8620 | 7266 | 1090 | −92 | 928 | C |
| ATOM | 2280 | CZ | PHE | A | 358 | 4.227 | 120.176 | 65.732 | 1.00 | 62.45 | | C |
| ANISOU | 2280 | CZ | PHE | A | 358 | 7891 | 8629 | 7210 | 1168 | 8 | 1260 | C |
| ATOM | 2281 | N | ASN | A | 359 | 9.397 | 122.197 | 70.788 | 1.00 | 50.08 | | N |
| ANISOU | 2281 | N | ASN | A | 359 | 8269 | 6335 | 4425 | 1496 | −274 | 50 | N |
| ATOM | 2282 | CA | ASN | A | 359 | 10.575 | 122.144 | 71.647 | 1.00 | 47.42 | | C |
| ANISOU | 2282 | CA | ASN | A | 359 | 8209 | 5897 | 3911 | 1346 | −509 | −72 | C |
| ATOM | 2283 | C | ASN | A | 359 | 10.169 | 121.711 | 73.043 | 1.00 | 47.53 | | C |
| ANISOU | 2283 | C | ASN | A | 359 | 8468 | 5872 | 3719 | 1576 | −361 | 0 | C |
| ATOM | 2284 | O | ASN | A | 359 | 10.137 | 122.512 | 73.972 | 1.00 | 50.50 | | O |
| ANISOU | 2284 | O | ASN | A | 359 | 9402 | 6028 | 3758 | 1724 | −329 | −39 | O |
| ATOM | 2285 | CB | ASN | A | 359 | 11.287 | 123.491 | 71.693 | 1.00 | 54.65 | | C |
| ANISOU | 2285 | CB | ASN | A | 359 | 9580 | 6588 | 4597 | 1230 | −715 | −205 | C |
| ATOM | 2286 | CG | ASN | A | 359 | 12.623 | 123.423 | 72.397 | 1.00 | 69.59 | | C |
| ANISOU | 2286 | CG | ASN | A | 359 | 11684 | 8401 | 6355 | 960 | −1059 | −257 | C |
| ATOM | 2287 | OD1 | ASN | A | 359 | 13.118 | 122.341 | 72.708 | 1.00 | 77.11 | | O |
| ANISOU | 2287 | OD1 | ASN | A | 359 | 12371 | 9494 | 7434 | 861 | −1132 | −197 | O |
| ATOM | 2288 | ND2 | ASN | A | 359 | 13.216 | 124.585 | 72.660 | 1.00 | 77.50 | | N |
| ANISOU | 2288 | ND2 | ASN | A | 359 | 13180 | 9172 | 7093 | 820 | −1293 | −331 | N |
| ATOM | 2289 | N | ASN | A | 360 | 9.874 | 120.421 | 73.175 | 1.00 | 38.36 | | N |
| ANISOU | 2289 | N | ASN | A | 360 | 6937 | 4898 | 2739 | 1598 | −274 | 108 | N |
| ATOM | 2290 | CA | ASN | A | 360 | 9.356 | 119.838 | 74.407 | 1.00 | 39.87 | | C |
| ANISOU | 2290 | CA | ASN | A | 360 | 7263 | 5097 | 2789 | 1833 | −97 | 211 | C |
| ATOM | 2291 | C | ASN | A | 360 | 9.646 | 118.331 | 74.362 | 1.00 | 41.33 | | C |
| ANISOU | 2291 | C | ASN | A | 360 | 7021 | 5481 | 3202 | 1684 | −164 | 264 | C |
| ATOM | 2292 | O | ASN | A | 360 | 10.038 | 117.821 | 73.315 | 1.00 | 35.90 | | O |
| ANISOU | 2292 | O | ASN | A | 360 | 5984 | 4899 | 2758 | 1460 | −279 | 244 | O |
| ATOM | 2293 | CB | ASN | A | 360 | 7.860 | 120.136 | 74.542 | 1.00 | 41.45 | | C |
| ANISOU | 2293 | CB | ASN | A | 360 | 7466 | 5319 | 2966 | 2215 | 283 | 424 | C |
| ATOM | 2294 | CG | ASN | A | 360 | 7.060 | 119.687 | 73.326 | 1.00 | 39.77 | | C |
| ANISOU | 2294 | CG | ASN | A | 360 | 6697 | 5318 | 3097 | 2158 | 360 | 598 | C |
| ATOM | 2295 | OD1 | ASN | A | 360 | 6.976 | 118.494 | 73.030 | 1.00 | 43.22 | | O |
| ANISOU | 2295 | OD1 | ASN | A | 360 | 6741 | 5929 | 3752 | 2011 | 305 | 683 | O |
| ATOM | 2296 | ND2 | ASN | A | 360 | 6.469 | 120.649 | 72.609 | 1.00 | 44.24 | | N |
| ANISOU | 2296 | ND2 | ASN | A | 360 | 7270 | 5848 | 3691 | 2254 | 469 | 667 | N |
| ATOM | 2297 | N | PRO | A | 361 | 9.459 | 117.613 | 75.484 | 1.00 | 39.01 | | N |
| ANISOU | 2297 | N | PRO | A | 361 | 6801 | 5213 | 2806 | 1823 | −73 | 336 | N |
| ATOM | 2298 | CA | PRO | A | 361 | 9.852 | 116.195 | 75.517 | 1.00 | 37.45 | | C |
| ANISOU | 2298 | CA | PRO | A | 361 | 6260 | 5177 | 2793 | 1677 | −149 | 374 | C |
| ATOM | 2299 | C | PRO | A | 361 | 9.050 | 115.232 | 74.622 | 1.00 | 35.90 | | C |
| ANISOU | 2299 | C | PRO | A | 361 | 5605 | 5159 | 2876 | 1647 | −38 | 524 | C |
| ATOM | 2300 | O | PRO | A | 361 | 9.473 | 114.090 | 74.455 | 1.00 | 48.58 | | O |
| ANISOU | 2300 | O | PRO | A | 361 | 6989 | 6853 | 4616 | 1499 | −113 | 535 | O |
| ATOM | 2301 | CB | PRO | A | 361 | 9.687 | 115.826 | 76.998 | 1.00 | 39.27 | | C |
| ANISOU | 2301 | CB | PRO | A | 361 | 6739 | 5369 | 2811 | 1867 | −55 | 425 | C |
| ATOM | 2302 | CG | PRO | A | 361 | 8.869 | 116.900 | 77.595 | 1.00 | 41.82 | | C |
| ANISOU | 2302 | CG | PRO | A | 361 | 7484 | 5534 | 2873 | 2182 | 167 | 470 | C |
| ATOM | 2303 | CD | PRO | A | 361 | 9.172 | 118.130 | 76.832 | 1.00 | 45.68 | | C |
| ANISOU | 2303 | CD | PRO | A | 361 | 8158 | 5888 | 3309 | 2086 | 60 | 351 | C |
| ATOM | 2304 | N | LEU | A | 362 | 7.951 | 115.684 | 74.031 | 1.00 | 36.30 | | N |
| ANISOU | 2304 | N | LEU | A | 362 | 5544 | 5245 | 3002 | 1762 | 118 | 665 | N |
| ATOM | 2305 | CA | LEU | A | 362 | 7.184 | 114.845 | 73.116 | 1.00 | 42.60 | | C |
| ANISOU | 2305 | CA | LEU | A | 362 | 5954 | 6188 | 4045 | 1650 | 141 | 852 | C |
| ATOM | 2306 | C | LEU | A | 362 | 7.877 | 114.604 | 71.778 | 1.00 | 45.45 | | C |
| ANISOU | 2306 | C | LEU | A | 362 | 6184 | 6527 | 4557 | 1339 | −54 | 727 | C |
| ATOM | 2307 | O | LEU | A | 362 | 7.444 | 113.760 | 71.002 | 1.00 | 51.40 | | O |
| ANISOU | 2307 | O | LEU | A | 362 | 6725 | 7342 | 5463 | 1179 | −91 | 850 | O |
| ATOM | 2308 | CB | LEU | A | 362 | 5.820 | 115.465 | 72.846 | 1.00 | 47.91 | | C |
| ANISOU | 2308 | CB | LEU | A | 362 | 6512 | 6920 | 4773 | 1837 | 335 | 1119 | C |
| ATOM | 2309 | CG | LEU | A | 362 | 4.636 | 115.020 | 73.704 | 1.00 | 56.18 | | C |
| ANISOU | 2309 | CG | LEU | A | 362 | 7424 | 8091 | 5829 | 2106 | 577 | 1463 | C |
| ATOM | 2310 | CD1 | LEU | A | 362 | 4.947 | 115.085 | 75.198 | 1.00 | 53.50 | | C |
| ANISOU | 2310 | CD1 | LEU | A | 362 | 7420 | 7670 | 5240 | 2373 | 715 | 1380 | C |
| ATOM | 2311 | CD2 | LEU | A | 362 | 3.423 | 115.870 | 73.354 | 1.00 | 61.77 | | C |
| ANISOU | 2311 | CD2 | LEU | A | 362 | 8008 | 8857 | 6606 | 2321 | 791 | 1782 | C |
| ATOM | 2312 | N | VAL | A | 363 | 8.935 | 115.356 | 71.492 | 1.00 | 46.00 | | N |
| ANISOU | 2312 | N | VAL | A | 363 | 6420 | 6491 | 4569 | 1246 | −182 | 512 | N |
| ATOM | 2313 | CA | VAL | A | 363 | 9.606 | 115.284 | 70.192 | 1.00 | 31.19 | | C |
| ANISOU | 2313 | CA | VAL | A | 363 | 4447 | 4579 | 2825 | 1008 | −314 | 419 | C |
| ATOM | 2314 | C | VAL | A | 363 | 11.112 | 115.367 | 70.390 | 1.00 | 33.13 | | C |
| ANISOU | 2314 | C | VAL | A | 363 | 4790 | 4769 | 3029 | 909 | −456 | 271 | C |
| ATOM | 2315 | O | VAL | A | 363 | 11.578 | 116.021 | 71.311 | 1.00 | 34.60 | | O |
| ANISOU | 2315 | O | VAL | A | 363 | 5179 | 4906 | 3061 | 970 | −521 | 211 | O |
| ATOM | 2316 | CB | VAL | A | 363 | 9.133 | 116.428 | 69.240 | 1.00 | 50.72 | | C |
| ANISOU | 2316 | CB | VAL | A | 363 | 6933 | 7005 | 5332 | 988 | −314 | 408 | C |
| ATOM | 2317 | CG1 | VAL | A | 363 | 9.981 | 116.509 | 67.984 | 1.00 | 48.57 | | C |
| ANISOU | 2317 | CG1 | VAL | A | 363 | 6625 | 6669 | 5159 | 767 | −442 | 290 | C |
| ATOM | 2318 | CG2 | VAL | A | 363 | 7.687 | 116.247 | 68.869 | 1.00 | 55.32 | | C |
| ANISOU | 2318 | CG2 | VAL | A | 363 | 7333 | 7673 | 6011 | 1034 | −205 | 649 | C |
| ATOM | 2319 | N | GLN | A | 364 | 11.878 | 114.677 | 69.557 | 1.00 | 29.84 | | N |
| ANISOU | 2319 | N | GLN | A | 364 | 4255 | 4347 | 2736 | 758 | −503 | 260 | N |
| ATOM | 2320 | CA | GLN | A | 364 | 13.307 | 114.880 | 69.559 | 1.00 | 35.19 | | C |
| ANISOU | 2320 | CA | GLN | A | 364 | 4945 | 4999 | 3426 | 671 | −622 | 218 | C |
| ATOM | 2321 | C | GLN | A | 364 | 13.569 | 116.167 | 68.797 | 1.00 | 37.52 | | C |
| ANISOU | 2321 | C | GLN | A | 364 | 5305 | 5225 | 3726 | 592 | −716 | 138 | C |
| ATOM | 2322 | O | GLN | A | 364 | 13.795 | 116.147 | 67.587 | 1.00 | 29.02 | | O |
| ANISOU | 2322 | O | GLN | A | 364 | 4146 | 4116 | 2765 | 505 | −698 | 132 | O |
| ATOM | 2323 | CB | GLN | A | 364 | 14.035 | 113.698 | 68.924 | 1.00 | 33.99 | | C |
| ANISOU | 2323 | CB | GLN | A | 364 | 4662 | 4855 | 3400 | 613 | −561 | 291 | C |
| ATOM | 2324 | CG | GLN | A | 364 | 14.567 | 112.725 | 69.941 | 1.00 | 48.25 | | C |
| ANISOU | 2324 | CG | GLN | A | 364 | 6420 | 6726 | 5188 | 669 | −543 | 377 | C |
| ATOM | 2325 | CD | GLN | A | 364 | 15.702 | 113.318 | 70.731 | 1.00 | 59.41 | | C |
| ANISOU | 2325 | CD | GLN | A | 364 | 7836 | 8172 | 6566 | 623 | −712 | 422 | C |
| ATOM | 2326 | OE1 | GLN | A | 364 | 16.370 | 114.254 | 70.269 | 1.00 | 72.26 | | O |
| ANISOU | 2326 | OE1 | GLN | A | 364 | 9464 | 9770 | 8223 | 523 | −837 | 425 | O |
| ATOM | 2327 | NE2 | GLN | A | 364 | 15.930 | 112.790 | 71.931 | 1.00 | 50.01 | | N |
| ANISOU | 2327 | NE2 | GLN | A | 364 | 6655 | 7038 | 5308 | 663 | −750 | 486 | N |
| ATOM | 2328 | N | PHE | A | 365 | 13.531 | 117.282 | 69.519 | 1.00 | 34.91 | | N |
| ANISOU | 2328 | N | PHE | A | 365 | 5180 | 4842 | 3240 | 628 | −811 | 78 | N |
| ATOM | 2329 | CA | PHE | A | 365 | 13.530 | 118.584 | 68.881 | 1.00 | 36.60 | | C |
| ANISOU | 2329 | CA | PHE | A | 365 | 5509 | 4972 | 3424 | 574 | −887 | −2 | C |
| ATOM | 2330 | C | PHE | A | 365 | 14.846 | 118.885 | 68.168 | 1.00 | 35.38 | | C |
| ANISOU | 2330 | C | PHE | A | 365 | 5260 | 4807 | 3375 | 387 | −1049 | 14 | C |
| ATOM | 2331 | O | PHE | A | 365 | 14.858 | 119.502 | 67.107 | 1.00 | 37.04 | | O |
| ANISOU | 2331 | O | PHE | A | 365 | 5435 | 4979 | 3661 | 322 | −1058 | −30 | O |
| ATOM | 2332 | CB | PHE | A | 365 | 13.226 | 119.682 | 69.893 | 1.00 | 46.88 | | C |
| ANISOU | 2332 | CB | PHE | A | 365 | 7170 | 6166 | 4476 | 670 | −939 | −60 | C |
| ATOM | 2333 | CG | PHE | A | 365 | 13.125 | 121.035 | 69.268 | 1.00 | 59.77 | | C |
| ANISOU | 2333 | CG | PHE | A | 365 | 8972 | 7688 | 6049 | 637 | −997 | −143 | C |
| ATOM | 2334 | CD1 | PHE | A | 365 | 12.241 | 121.257 | 68.226 | 1.00 | 59.74 | | C |
| ANISOU | 2334 | CD1 | PHE | A | 365 | 8825 | 7708 | 6165 | 694 | −852 | −144 | C |
| ATOM | 2335 | CD2 | PHE | A | 365 | 13.930 | 122.076 | 69.694 | 1.00 | 68.30 | | C |
| ANISOU | 2335 | CD2 | PHE | A | 365 | 10367 | 8633 | 6950 | 513 | −1229 | −194 | C |
| ATOM | 2336 | CE1 | PHE | A | 365 | 12.151 | 122.493 | 67.632 | 1.00 | 64.41 | | C |
| ANISOU | 2336 | CE1 | PHE | A | 365 | 9562 | 8201 | 6709 | 672 | −895 | −215 | C |
| ATOM | 2337 | CE2 | PHE | A | 365 | 13.842 | 123.315 | 69.108 | 1.00 | 70.37 | | C |
| ANISOU | 2337 | CE2 | PHE | A | 365 | 10813 | 8778 | 7146 | 477 | −1286 | −272 | C |
| ATOM | 2338 | CZ | PHE | A | 365 | 12.950 | 123.526 | 68.076 | 1.00 | 69.24 | | C |
| ANISOU | 2338 | CZ | PHE | A | 365 | 10501 | 8670 | 7135 | 577 | −1098 | −293 | C |
| ATOM | 2339 | N | ASP | A | 366 | 15.940 | 118.437 | 68.762 | 1.00 | 41.50 | | N |
| ANISOU | 2339 | N | ASP | A | 366 | 5971 | 5630 | 4168 | 306 | −1170 | 122 | N |
| ATOM | 2340 | CA | ASP | A | 366 | 17.271 | 118.505 | 68.166 | 1.00 | 43.47 | | C |
| ANISOU | 2340 | CA | ASP | A | 366 | 6037 | 5915 | 4564 | 156 | −1290 | 260 | C |
| ATOM | 2341 | C | ASP | A | 366 | 17.254 | 118.107 | 66.705 | 1.00 | 40.26 | | C |
| ANISOU | 2341 | C | ASP | A | 366 | 5451 | 5510 | 4337 | 184 | −1106 | 267 | C |
| ATOM | 2342 | O | ASP | A | 366 | 17.691 | 118.865 | 65.841 | 1.00 | 42.01 | | O |
| ANISOU | 2342 | O | ASP | A | 366 | 5638 | 5699 | 4626 | 99 | −1167 | 275 | O |
| ATOM | 2343 | CB | ASP | A | 366 | 18.233 | 117.585 | 68.920 | 1.00 | 56.90 | | C |
| ANISOU | 2343 | CB | ASP | A | 366 | 7582 | 7715 | 6324 | 130 | −1341 | 464 | C |
| ATOM | 2344 | CG | ASP | A | 366 | 18.899 | 118.280 | 70.067 | 1.00 | 72.80 | | C |
| ANISOU | 2344 | CG | ASP | A | 366 | 9761 | 9709 | 8189 | −36 | −1659 | 552 | C |
| ATOM | 2345 | OD1 | ASP | A | 366 | 18.813 | 119.529 | 70.118 | 1.00 | 79.17 | | O |
| ANISOU | 2345 | OD1 | ASP | A | 366 | 10828 | 10403 | 8850 | −148 | −1850 | 461 | O |
| ATOM | 2346 | OD2 | ASP | A | 366 | 19.501 | 117.591 | 70.919 | 1.00 | 80.11 | | O |
| ANISOU | 2346 | OD2 | ASP | A | 366 | 10603 | 10712 | 9124 | −70 | −1736 | 721 | O |
| ATOM | 2347 | N | ASP | A | 367 | 16.747 | 116.904 | 66.437 | 1.00 | 39.21 | | N |
| ANISOU | 2347 | N | ASP | A | 367 | 5256 | 5390 | 4253 | 292 | −892 | 273 | N |
| ATOM | 2348 | CA | ASP | A | 367 | 16.710 | 116.372 | 65.079 | 1.00 | 37.98 | | C |
| ANISOU | 2348 | CA | ASP | A | 367 | 5055 | 5172 | 4202 | 310 | −715 | 286 | C |
| ATOM | 2349 | C | ASP | A | 367 | 15.783 | 117.130 | 64.163 | 1.00 | 32.40 | | C |
| ANISOU | 2349 | C | ASP | A | 367 | 4449 | 4386 | 3475 | 261 | −717 | 144 | C |
| ATOM | 2350 | O | ASP | A | 367 | 16.059 | 117.250 | 62.972 | 1.00 | 31.05 | | O |
| ANISOU | 2350 | O | ASP | A | 367 | 4282 | 4142 | 3374 | 222 | −656 | 150 | O |
| ATOM | 2351 | CB | ASP | A | 367 | 16.291 | 114.910 | 65.092 | 1.00 | 44.65 | | C |
| ANISOU | 2351 | CB | ASP | A | 367 | 5925 | 5998 | 5041 | 397 | −531 | 326 | C |
| ATOM | 2352 | CG | ASP | A | 367 | 17.253 | 114.068 | 65.833 | 1.00 | 51.22 | | C |
| ANISOU | 2352 | CG | ASP | A | 367 | 6644 | 6905 | 5913 | 470 | −484 | 494 | C |
| ATOM | 2353 | OD1 | ASP | A | 367 | 18.407 | 114.531 | 65.977 | 1.00 | 51.77 | | O |
| ANISOU | 2353 | OD1 | ASP | A | 367 | 6569 | 7038 | 6063 | 439 | −572 | 643 | O |
| ATOM | 2354 | OD2 | ASP | A | 367 | 16.865 | 112.963 | 66.256 | 1.00 | 54.78 | | O |
| ANISOU | 2354 | OD2 | ASP | A | 367 | 7133 | 7356 | 6325 | 541 | −376 | 514 | O |
| ATOM | 2355 | N | PHE | A | 368 | 14.684 | 117.632 | 64.718 | 1.00 | 27.88 | | N |
| ANISOU | 2355 | N | PHE | A | 368 | 3963 | 3825 | 2806 | 285 | −763 | 50 | N |
| ATOM | 2356 | CA | PHE | A | 368 | 13.679 | 118.319 | 63.923 | 1.00 | 29.63 | | C |
| ANISOU | 2356 | CA | PHE | A | 368 | 4239 | 3995 | 3025 | 254 | −752 | −24 | C |
| ATOM | 2357 | C | PHE | A | 368 | 14.271 | 119.660 | 63.421 | 1.00 | 29.60 | | C |
| ANISOU | 2357 | C | PHE | A | 368 | 4271 | 3947 | 3030 | 183 | −870 | −91 | C |
| ATOM | 2358 | O | PHE | A | 368 | 14.261 | 119.953 | 62.222 | 1.00 | 28.93 | | O |
| ANISOU | 2358 | O | PHE | A | 368 | 4174 | 3802 | 3016 | 111 | −851 | −117 | O |
| ATOM | 2359 | CB | PHE | A | 368 | 12.409 | 118.480 | 64.771 | 1.00 | 30.15 | | C |
| ANISOU | 2359 | CB | PHE | A | 368 | 4349 | 4107 | 3000 | 361 | −717 | −14 | C |
| ATOM | 2360 | CG | PHE | A | 368 | 11.199 | 118.965 | 64.016 | 1.00 | 35.03 | | C |
| ANISOU | 2360 | CG | PHE | A | 368 | 4951 | 4711 | 3649 | 348 | −677 | 15 | C |
| ATOM | 2361 | CD1 | PHE | A | 368 | 11.264 | 119.310 | 62.686 | 1.00 | 26.76 | | C |
| ANISOU | 2361 | CD1 | PHE | A | 368 | 3896 | 3595 | 2678 | 216 | −712 | −18 | C |
| ATOM | 2362 | CD2 | PHE | A | 368 | 9.982 | 119.075 | 64.663 | 1.00 | 44.65 | | C |
| ANISOU | 2362 | CD2 | PHE | A | 368 | 6150 | 5992 | 4824 | 481 | −594 | 124 | C |
| ATOM | 2363 | CE1 | PHE | A | 368 | 10.139 | 119.774 | 62.014 | 1.00 | 34.79 | | C |
| ANISOU | 2363 | CE1 | PHE | A | 368 | 4877 | 4610 | 3732 | 180 | −704 | 52 | C |
| ATOM | 2364 | CE2 | PHE | A | 368 | 8.851 | 119.542 | 63.999 | 1.00 | 46.11 | | C |
| ANISOU | 2364 | CE2 | PHE | A | 368 | 6259 | 6195 | 5068 | 475 | −556 | 242 | C |
| ATOM | 2365 | CZ | PHE | A | 368 | 8.929 | 119.885 | 62.670 | 1.00 | 35.98 | | C |
| ANISOU | 2365 | CZ | PHE | A | 368 | 4958 | 4847 | 3865 | 304 | −631 | 204 | C |
| ATOM | 2366 | N | ARG | A | 369 | 14.847 | 120.427 | 64.334 | 1.00 | 30.45 | | N |
| ANISOU | 2366 | N | ARG | A | 369 | 4457 | 4063 | 3049 | 176 | −1015 | −105 | N |
| ATOM | 2367 | CA | ARG | A | 369 | 15.521 | 121.672 | 63.992 | 1.00 | 31.41 | | C |
| ANISOU | 2367 | CA | ARG | A | 369 | 4643 | 4132 | 3158 | 66 | −1179 | −137 | C |
| ATOM | 2368 | C | ARG | A | 369 | 16.746 | 121.410 | 63.093 | 1.00 | 34.75 | | C |
| ANISOU | 2368 | C | ARG | A | 369 | 4873 | 4580 | 3750 | −30 | −1193 | −17 | C |
| ATOM | 2369 | O | ARG | A | 369 | 17.056 | 122.206 | 62.199 | 1.00 | 28.65 | | O |
| ANISOU | 2369 | O | ARG | A | 369 | 4086 | 3765 | 3034 | −110 | −1246 | −33 | O |
| ATOM | 2370 | CB | ARG | A | 369 | 15.901 | 122.405 | 65.289 | 1.00 | 40.73 | | C |
| ANISOU | 2370 | CB | ARG | A | 369 | 6043 | 5277 | 4155 | 32 | −1378 | −140 | C |
| ATOM | 2371 | CG | ARG | A | 369 | 16.866 | 123.577 | 65.191 | 1.00 | 52.85 | | C |
| ANISOU | 2371 | CG | ARG | A | 369 | 7682 | 6749 | 5648 | −157 | −1643 | −111 | C |
| ATOM | 2372 | CD | ARG | A | 369 | 17.116 | 124.137 | 66.603 | 1.00 | 59.79 | | C |
| ANISOU | 2372 | CD | ARG | A | 369 | 8907 | 7539 | 6273 | −223 | −1869 | −103 | C |
| ATOM | 2373 | NE | ARG | A | 369 | 17.896 | 125.379 | 66.665 | 1.00 | 72.84 | | N |
| ANISOU | 2373 | NE | ARG | A | 369 | 10787 | 9080 | 7810 | −456 | −2191 | −68 | N |
| ATOM | 2374 | CZ | ARG | A | 369 | 17.426 | 126.606 | 66.421 | 1.00 | 79.47 | | C |
| ANISOU | 2374 | CZ | ARG | A | 369 | 11930 | 9759 | 8504 | −454 | −2217 | −206 | C |
| ATOM | 2375 | NH1 | ARG | A | 369 | 16.158 | 126.793 | 66.059 | 1.00 | 76.67 | | N |
| ANISOU | 2375 | NH1 | ARG | A | 369 | 11671 | 9362 | 8098 | −216 | −1957 | −366 | N |
| ATOM | 2376 | NH2 | ARG | A | 369 | 18.240 | 127.651 | 66.532 | 1.00 | 80.29 | | N |
| ANISOU | 2376 | NH2 | ARG | A | 369 | 12148 | 9749 | 8608 | −668 | −2390 | −127 | N |
| ATOM | 2377 | N | LYS | A | 370 | 17.428 | 120.286 | 63.320 | 1.00 | 29.21 | | N |
| ANISOU | 2377 | N | LYS | A | 370 | 4025 | 3945 | 3130 | 10 | −1112 | 134 | N |
| ATOM | 2378 | CA | LYS | A | 370 | 18.580 | 119.912 | 62.507 | 1.00 | 36.29 | | C |
| ANISOU | 2378 | CA | LYS | A | 370 | 4735 | 4865 | 4190 | 2 | −1035 | 326 | C |
| ATOM | 2379 | C | LYS | A | 370 | 18.131 | 119.791 | 61.049 | 1.00 | 37.73 | | C |
| ANISOU | 2379 | C | LYS | A | 370 | 4974 | 4942 | 4419 | 38 | −849 | 245 | C |
| ATOM | 2380 | O | LYS | A | 370 | 18.763 | 120.322 | 60.123 | 1.00 | 36.18 | | O |
| ANISOU | 2380 | O | LYS | A | 370 | 4720 | 4716 | 4312 | 3 | −839 | 313 | O |
| ATOM | 2381 | CB | LYS | A | 370 | 19.190 | 118.605 | 63.019 | 1.00 | 43.54 | | C |
| ANISOU | 2381 | CB | LYS | A | 370 | 5523 | 5854 | 5167 | 104 | −903 | 518 | C |
| ATOM | 2382 | CG | LYS | A | 370 | 20.509 | 118.208 | 62.370 | 1.00 | 54.62 | | C |
| ANISOU | 2382 | CG | LYS | A | 370 | 6712 | 7297 | 6743 | 164 | −772 | 819 | C |
| ATOM | 2383 | CD | LYS | A | 370 | 21.015 | 116.878 | 62.930 | 1.00 | 61.59 | | C |
| ANISOU | 2383 | CD | LYS | A | 370 | 7487 | 8242 | 7672 | 309 | −599 | 1027 | C |
| ATOM | 2384 | CE | LYS | A | 370 | 22.277 | 116.414 | 62.217 | 1.00 | 73.25 | | C |
| ANISOU | 2384 | CE | LYS | A | 370 | 8757 | 9749 | 9325 | 452 | −370 | 1395 | C |
| ATOM | 2385 | NZ | LYS | A | 370 | 23.369 | 117.436 | 62.271 | 1.00 | 79.70 | | N |
| ANISOU | 2385 | NZ | LYS | A | 370 | 9294 | 10697 | 10290 | 309 | −599 | 1680 | N |
| ATOM | 2386 | N | SER | A | 371 | 17.019 | 119.090 | 60.870 | 1.00 | 31.30 | | N |
| ANISOU | 2386 | N | SER | A | 371 | 4290 | 4066 | 3537 | 86 | −726 | 128 | N |
| ATOM | 2387 | CA | SER | A | 371 | 16.420 | 118.876 | 59.562 | 1.00 | 31.66 | | C |
| ANISOU | 2387 | CA | SER | A | 371 | 4470 | 3980 | 3581 | 63 | −605 | 62 | C |
| ATOM | 2388 | C | SER | A | 371 | 16.002 | 120.207 | 58.900 | 1.00 | 35.06 | | C |
| ANISOU | 2388 | C | SER | A | 371 | 4929 | 4378 | 4016 | −37 | −725 | −57 | C |
| ATOM | 2389 | O | SER | A | 371 | 16.325 | 120.468 | 57.727 | 1.00 | 27.30 | | O |
| ANISOU | 2389 | O | SER | A | 371 | 3990 | 3304 | 3079 | −70 | −668 | −51 | O |
| ATOM | 2390 | CB | SER | A | 371 | 15.229 | 117.933 | 59.701 | 1.00 | 33.03 | | C |
| ANISOU | 2390 | CB | SER | A | 371 | 4768 | 4111 | 3670 | 59 | −547 | 20 | C |
| ATOM | 2391 | OG | SER | A | 371 | 14.682 | 117.626 | 58.447 | 1.00 | 39.76 | | O |
| ANISOU | 2391 | OG | SER | A | 371 | 5808 | 4806 | 4491 | −25 | −484 | −2 | O |
| ATOM | 2392 | N | LEU | A | 372 | 15.278 | 121.039 | 59.650 | 1.00 | 26.06 | | N |
| ANISOU | 2392 | N | LEU | A | 372 | 3798 | 3293 | 2810 | −56 | −862 | −151 | N |
| ATOM | 2393 | CA | LEU | A | 372 | 14.887 | 122.360 | 59.159 | 1.00 | 41.30 | | C |
| ANISOU | 2393 | CA | LEU | A | 372 | 5775 | 5188 | 4729 | −119 | −961 | −249 | C |
| ATOM | 2394 | C | LEU | A | 372 | 16.067 | 123.194 | 58.691 | 1.00 | 36.48 | | C |
| ANISOU | 2394 | C | LEU | A | 372 | 5112 | 4566 | 4184 | −190 | −1055 | −218 | C |
| ATOM | 2395 | O | LEU | A | 372 | 16.011 | 123.790 | 57.619 | 1.00 | 34.71 | | O |
| ANISOU | 2395 | O | LEU | A | 372 | 4909 | 4277 | 4003 | −248 | −1051 | −264 | O |
| ATOM | 2396 | CB | LEU | A | 372 | 14.130 | 123.135 | 60.238 | 1.00 | 40.09 | | C |
| ANISOU | 2396 | CB | LEU | A | 372 | 5706 | 5070 | 4458 | −60 | −1041 | −312 | C |
| ATOM | 2397 | CG | LEU | A | 372 | 12.630 | 122.907 | 60.116 | 1.00 | 38.55 | | C |
| ANISOU | 2397 | CG | LEU | A | 372 | 5518 | 4883 | 4245 | −5 | −944 | −298 | C |
| ATOM | 2398 | CD1 | LEU | A | 372 | 11.892 | 123.478 | 61.328 | 1.00 | 38.07 | | C |
| ANISOU | 2398 | CD1 | LEU | A | 372 | 5556 | 4854 | 4056 | 149 | −926 | −295 | C |
| ATOM | 2399 | CD2 | LEU | A | 372 | 12.150 | 123.521 | 58.804 | 1.00 | 30.30 | | C |
| ANISOU | 2399 | CD2 | LEU | A | 372 | 4471 | 3777 | 3263 | −98 | −951 | −323 | C |
| ATOM | 2400 | N | LYS | A | 373 | 17.134 | 123.230 | 59.486 | 1.00 | 34.94 | | N |
| ANISOU | 2400 | N | LYS | A | 373 | 4833 | 4440 | 4003 | −206 | −1159 | −102 | N |
| ATOM | 2401 | CA | LYS | A | 373 | 18.270 | 124.092 | 59.166 | 1.00 | 35.71 | | C |
| ANISOU | 2401 | CA | LYS | A | 373 | 4840 | 4552 | 4175 | −315 | −1306 | 8 | C |
| ATOM | 2402 | C | LYS | A | 373 | 18.952 | 123.617 | 57.898 | 1.00 | 36.29 | | C |
| ANISOU | 2402 | C | LYS | A | 373 | 4785 | 4604 | 4400 | −271 | −1121 | 142 | C |
| ATOM | 2403 | O | LYS | A | 373 | 19.408 | 124.418 | 57.084 | 1.00 | 34.40 | | O |
| ANISOU | 2403 | O | LYS | A | 373 | 4501 | 4339 | 4229 | −338 | −1168 | 177 | O |
| ATOM | 2404 | CB | LYS | A | 373 | 19.292 | 124.132 | 60.303 | 1.00 | 41.32 | | C |
| ANISOU | 2404 | CB | LYS | A | 373 | 5467 | 5353 | 4881 | −393 | −1505 | 196 | C |
| ATOM | 2405 | CG | LYS | A | 373 | 18.803 | 124.705 | 61.621 | 1.00 | 49.63 | | C |
| ANISOU | 2405 | CG | LYS | A | 373 | 6759 | 6373 | 5725 | −445 | −1707 | 83 | C |
| ATOM | 2406 | CD | LYS | A | 373 | 18.193 | 126.077 | 61.472 | 1.00 | 56.40 | | C |
| ANISOU | 2406 | CD | LYS | A | 373 | 7875 | 7112 | 6442 | −503 | −1830 | −100 | C |
| ATOM | 2407 | CE | LYS | A | 373 | 18.125 | 126.767 | 62.828 | 1.00 | 66.71 | | C |
| ANISOU | 2407 | CE | LYS | A | 373 | 9520 | 8333 | 7496 | −569 | −2057 | −140 | C |
| ATOM | 2408 | NZ | LYS | A | 373 | 17.440 | 128.085 | 62.765 | 1.00 | 71.92 | | N |
| ANISOU | 2408 | NZ | LYS | A | 373 | 10520 | 8833 | 7973 | −561 | −2104 | −313 | N |
| ATOM | 2409 | N | SER | A | 374 | 19.023 | 122.303 | 57.747 | 1.00 | 33.51 | | N |
| ANISOU | 2409 | N | SER | A | 374 | 4416 | 4239 | 4076 | −140 | −889 | 227 | N |
| ATOM | 2410 | CA | SER | A | 374 | 19.600 | 121.708 | 56.559 | 1.00 | 34.19 | | C |
| ANISOU | 2410 | CA | SER | A | 374 | 4502 | 4244 | 4246 | −34 | −635 | 362 | C |
| ATOM | 2411 | C | SER | A | 374 | 18.770 | 122.096 | 55.332 | 1.00 | 30.03 | | C |
| ANISOU | 2411 | C | SER | A | 374 | 4181 | 3565 | 3665 | −85 | −585 | 172 | C |
| ATOM | 2412 | O | SER | A | 374 | 19.294 | 122.586 | 54.319 | 1.00 | 29.58 | | O |
| ANISOU | 2412 | O | SER | A | 374 | 4117 | 3449 | 3672 | −83 | −522 | 233 | O |
| ATOM | 2413 | CB | SER | A | 374 | 19.669 | 120.194 | 56.729 | 1.00 | 36.18 | | C |
| ANISOU | 2413 | CB | SER | A | 374 | 4821 | 4456 | 4471 | 128 | −387 | 463 | C |
| ATOM | 2414 | OG | SER | A | 374 | 20.555 | 119.607 | 55.802 | 1.00 | 41.52 | | O |
| ANISOU | 2414 | OG | SER | A | 374 | 5519 | 5045 | 5211 | 297 | −95 | 682 | O |
| ATOM | 2415 | N | ILE | A | 375 | 17.463 | 121.903 | 55.449 | 1.00 | 29.96 | | N |
| ANISOU | 2415 | N | ILE | A | 375 | 4334 | 3503 | 3546 | −141 | −627 | −19 | N |
| ATOM | 2416 | CA | ILE | A | 375 | 16.545 | 122.240 | 54.370 | 1.00 | 27.69 | | C |
| ANISOU | 2416 | CA | ILE | A | 375 | 4224 | 3086 | 3209 | −236 | −631 | −153 | C |
| ATOM | 2417 | C | ILE | A | 375 | 16.701 | 123.712 | 54.014 | 1.00 | 29.30 | | C |
| ANISOU | 2417 | C | ILE | A | 375 | 4343 | 3323 | 3467 | −320 | −782 | −219 | C |
| ATOM | 2418 | O | ILE | A | 375 | 16.836 | 124.057 | 52.850 | 1.00 | 38.64 | | O |
| ANISOU | 2418 | O | ILE | A | 375 | 5605 | 4404 | 4674 | −356 | −730 | −232 | O |
| ATOM | 2419 | CB | ILE | A | 375 | 15.090 | 121.859 | 54.759 | 1.00 | 24.99 | | C |
| ANISOU | 2419 | CB | ILE | A | 375 | 3975 | 2743 | 2779 | −304 | −698 | −242 | C |
| ATOM | 2420 | CG1 | ILE | A | 375 | 14.955 | 120.328 | 54.744 | 1.00 | 26.16 | | C |
| ANISOU | 2420 | CG1 | ILE | A | 375 | 4289 | 2798 | 2854 | −267 | −554 | −167 | C |
| ATOM | 2421 | CG2 | ILE | A | 375 | 14.064 | 122.462 | 53.817 | 1.00 | 24.44 | | C |
| ANISOU | 2421 | CG2 | ILE | A | 375 | 4005 | 2592 | 2687 | −444 | −778 | −319 | C |
| ATOM | 2422 | CD1 | ILE | A | 375 | 13.597 | 119.805 | 55.120 | 1.00 | 27.05 | | C |
| ANISOU | 2422 | CD1 | ILE | A | 375 | 4459 | 2922 | 2898 | −362 | −637 | −173 | C |
| ATOM | 2423 | N | ILE | A | 376 | 16.755 | 124.572 | 55.020 | 1.00 | 31.83 | | N |
| ANISOU | 2423 | N | ILE | A | 376 | 4554 | 3758 | 3782 | −349 | −967 | −253 | N |
| ATOM | 2424 | CA | ILE | A | 376 | 16.899 | 126.006 | 54.777 | 1.00 | 34.40 | | C |
| ANISOU | 2424 | CA | ILE | A | 376 | 4864 | 4085 | 4121 | −440 | −1131 | −317 | C |
| ATOM | 2425 | C | ILE | A | 376 | 18.287 | 126.396 | 54.261 | 1.00 | 34.64 | | C |
| ANISOU | 2425 | C | ILE | A | 376 | 4756 | 4137 | 4270 | −471 | −1152 | −154 | C |
| ATOM | 2426 | O | ILE | A | 376 | 18.409 | 127.193 | 53.348 | 1.00 | 34.30 | | O |
| ANISOU | 2426 | O | ILE | A | 376 | 4723 | 4041 | 4267 | −532 | −1181 | −184 | O |
| ATOM | 2427 | CB | ILE | A | 376 | 16.574 | 126.806 | 56.058 | 1.00 | 33.49 | | C |
| ANISOU | 2427 | CB | ILE | A | 376 | 4803 | 4024 | 3900 | −459 | −1319 | −387 | C |
| ATOM | 2428 | CG1 | ILE | A | 376 | 15.080 | 126.666 | 56.377 | 1.00 | 33.65 | | C |
| ANISOU | 2428 | CG1 | ILE | A | 376 | 4929 | 4030 | 3827 | −388 | −1252 | −494 | C |
| ATOM | 2429 | CG2 | ILE | A | 376 | 16.925 | 128.277 | 55.896 | 1.00 | 26.02 | | C |
| ANISOU | 2429 | CG2 | ILE | A | 376 | 3914 | 3043 | 2929 | −567 | −1510 | −431 | C |
| ATOM | 2430 | CD1 | ILE | A | 376 | 14.669 | 127.393 | 57.625 | 1.00 | 36.16 | | C |
| ANISOU | 2430 | CD1 | ILE | A | 376 | 5386 | 4356 | 3997 | −328 | −1348 | −545 | C |
| ATOM | 2431 | N | ALA | A | 377 | 19.334 | 125.813 | 54.825 | 1.00 | 37.39 | | N |
| ANISOU | 2431 | N | ALA | A | 377 | 4945 | 4573 | 4689 | −424 | −1130 | 67 | N |
| ATOM | 2432 | CA | ALA | A | 377 | 20.681 | 126.179 | 54.422 | 1.00 | 34.89 | | C |
| ANISOU | 2432 | CA | ALA | A | 377 | 4420 | 4317 | 4520 | −448 | −1154 | 335 | C |
| ATOM | 2433 | C | ALA | A | 377 | 20.938 | 125.800 | 52.969 | 1.00 | 37.40 | | C |
| ANISOU | 2433 | C | ALA | A | 377 | 4767 | 4532 | 4912 | −326 | −867 | 406 | C |
| ATOM | 2434 | O | ALA | A | 377 | 21.629 | 126.523 | 52.252 | 1.00 | 39.43 | | O |
| ANISOU | 2434 | O | ALA | A | 377 | 4913 | 4799 | 5272 | −360 | −887 | 538 | O |
| ATOM | 2435 | CB | ALA | A | 377 | 21.708 | 125.532 | 55.330 | 1.00 | 31.00 | | C |
| ANISOU | 2435 | CB | ALA | A | 377 | 3707 | 3961 | 4112 | −412 | −1172 | 641 | C |
| ATOM | 2436 | N | LYS | A | 378 | 20.382 | 124.677 | 52.520 | 1.00 | 40.34 | | N |
| ANISOU | 2436 | N | LYS | A | 378 | 4224 | 4382 | 6721 | −914 | −1153 | −140 | N |
| ATOM | 2437 | CA | LYS | A | 378 | 20.683 | 124.221 | 51.167 | 1.00 | 37.83 | | C |
| ANISOU | 2437 | CA | LYS | A | 378 | 3820 | 4078 | 6475 | −941 | −870 | −33 | C |
| ATOM | 2438 | C | LYS | A | 378 | 19.658 | 124.764 | 50.168 | 1.00 | 40.33 | | C |
| ANISOU | 2438 | C | LYS | A | 378 | 4329 | 4411 | 6585 | −933 | −663 | 69 | C |
| ATOM | 2439 | O | LYS | A | 378 | 19.736 | 124.479 | 48.980 | 1.00 | 43.83 | | O |
| ANISOU | 2439 | O | LYS | A | 378 | 4786 | 4854 | 7013 | −950 | −425 | 165 | O |
| ATOM | 2440 | CB | LYS | A | 378 | 20.712 | 122.688 | 51.106 | 1.00 | 40.95 | | C |
| ANISOU | 2440 | CB | LYS | A | 378 | 4181 | 4602 | 6775 | −868 | −862 | −15 | C |
| ATOM | 2441 | CG | LYS | A | 378 | 21.308 | 122.145 | 49.793 | 1.00 | 56.84 | | C |
| ANISOU | 2441 | CG | LYS | A | 378 | 6081 | 6601 | 8916 | −903 | −573 | 67 | C |
| ATOM | 2442 | CD | LYS | A | 378 | 21.343 | 120.619 | 49.706 | 1.00 | 61.50 | | C |
| ANISOU | 2442 | CD | LYS | A | 378 | 6637 | 7305 | 9425 | −828 | −560 | 77 | C |
| ATOM | 2443 | CE | LYS | A | 378 | 21.830 | 120.145 | 48.340 | 1.00 | 54.35 | | C |
| ANISOU | 2443 | CE | LYS | A | 378 | 5667 | 6374 | 8608 | −860 | −237 | 150 | C |
| ATOM | 2444 | NZ | LYS | A | 378 | 23.097 | 120.838 | 47.977 | 1.00 | 55.59 | | N |
| ANISOU | 2444 | NZ | LYS | A | 378 | 5601 | 6358 | 9164 | −971 | −96 | 132 | N |
| ATOM | 2445 | N | GLU | A | 379 | 18.732 | 125.592 | 50.650 | 1.00 | 40.16 | | N |
| ANISOU | 2445 | N | GLU | A | 379 | 4466 | 4380 | 6415 | −905 | −762 | 42 | N |
| ATOM | 2446 | CA | GLU | A | 379 | 17.641 | 126.114 | 49.827 | 1.00 | 38.12 | | C |
| ANISOU | 2446 | CA | GLU | A | 379 | 4391 | 4121 | 5970 | −874 | −633 | 127 | C |
| ATOM | 2447 | C | GLU | A | 379 | 16.852 | 124.979 | 49.173 | 1.00 | 40.63 | | C |
| ANISOU | 2447 | C | GLU | A | 379 | 4803 | 4581 | 6055 | −792 | −543 | 195 | C |
| ATOM | 2448 | O | GLU | A | 379 | 16.482 | 125.040 | 47.998 | 1.00 | 39.51 | | O |
| ANISOU | 2448 | O | GLU | A | 379 | 4767 | 4421 | 5823 | −789 | −386 | 295 | O |
| ATOM | 2449 | CB | GLU | A | 379 | 18.172 | 127.104 | 48.778 | 1.00 | 35.44 | | C |
| ANISOU | 2449 | CB | GLU | A | 379 | 4049 | 3625 | 5790 | −969 | −445 | 211 | C |
| ATOM | 2450 | CG | GLU | A | 379 | 18.756 | 128.348 | 49.422 | 1.00 | 44.34 | | C |
| ANISOU | 2450 | CG | GLU | A | 379 | 5100 | 4596 | 7151 | −1051 | −543 | 139 | C |
| ATOM | 2451 | CD | GLU | A | 379 | 19.146 | 129.443 | 48.443 | 1.00 | 53.52 | | C |
| ANISOU | 2451 | CD | GLU | A | 379 | 6294 | 5580 | 8463 | −1149 | −346 | 228 | C |
| ATOM | 2452 | OE1 | GLU | A | 379 | 19.417 | 129.159 | 47.258 | 1.00 | 53.28 | | O |
| ANISOU | 2452 | OE1 | GLU | A | 379 | 6301 | 5523 | 8419 | −1182 | −101 | 340 | O |
| ATOM | 2453 | OE2 | GLU | A | 379 | 19.164 | 130.612 | 48.872 | 1.00 | 61.95 | | O |
| ANISOU | 2453 | OE2 | GLU | A | 379 | 7374 | 6517 | 9647 | −1194 | −430 | 184 | O |
| ATOM | 2454 | N | ASN | A | 380 | 16.575 | 123.946 | 49.964 | 1.00 | 44.30 | | N |
| ANISOU | 2454 | N | ASN | A | 380 | 5253 | 5168 | 6411 | −726 | −659 | 138 | N |
| ATOM | 2455 | CA | ASN | A | 380 | 15.821 | 122.794 | 49.492 | 1.00 | 33.59 | | C |
| ANISOU | 2455 | CA | ASN | A | 380 | 3967 | 3938 | 4856 | −651 | −597 | 184 | C |
| ATOM | 2456 | C | ASN | A | 380 | 14.345 | 123.134 | 49.359 | 1.00 | 24.08 | | C |
| ANISOU | 2456 | C | ASN | A | 380 | 2921 | 2758 | 3470 | −583 | −612 | 197 | C |
| ATOM | 2457 | O | ASN | A | 380 | 13.514 | 122.674 | 50.134 | 1.00 | 23.19 | | O |
| ANISOU | 2457 | O | ASN | A | 380 | 2852 | 2719 | 3240 | −519 | −693 | 140 | O |
| ATOM | 2458 | CB | ASN | A | 380 | 16.021 | 121.604 | 50.422 | 1.00 | 24.40 | | C |
| ANISOU | 2458 | CB | ASN | A | 380 | 2744 | 2874 | 3653 | −608 | −710 | 124 | C |
| ATOM | 2459 | CG | ASN | A | 380 | 15.532 | 120.291 | 49.806 | 1.00 | 24.00 | | C |
| ANISOU | 2459 | CG | ASN | A | 380 | 2727 | 2935 | 3455 | −550 | −621 | 174 | C |
| ATOM | 2460 | OD1 | ASN | A | 380 | 14.901 | 120.288 | 48.748 | 1.00 | 24.01 | | O |
| ANISOU | 2460 | OD1 | ASN | A | 380 | 2817 | 2947 | 3361 | −533 | −504 | 243 | O |
| ATOM | 2461 | ND2 | ASN | A | 380 | 15.811 | 119.170 | 50.480 | 1.00 | 24.53 | | N |
| ANISOU | 2461 | ND2 | ASN | A | 380 | 2746 | 3073 | 3503 | −515 | −700 | 139 | N |
| ATOM | 2462 | N | MET | A | 381 | 14.050 | 123.964 | 48.363 | 1.00 | 34.63 | | N |
| ANISOU | 2462 | N | MET | A | 381 | 4346 | 4009 | 4805 | −599 | −528 | 271 | N |
| ATOM | 2463 | CA | MET | A | 381 | 12.700 | 124.365 | 48.008 | 1.00 | 27.26 | | C |
| ANISOU | 2463 | CA | MET | A | 381 | 3546 | 3061 | 3749 | −530 | −560 | 292 | C |
| ATOM | 2464 | C | MET | A | 381 | 11.720 | 123.214 | 47.866 | 1.00 | 27.34 | | C |
| ANISOU | 2464 | C | MET | A | 381 | 3590 | 3188 | 3610 | −446 | −578 | 290 | C |
| ATOM | 2465 | O | MET | A | 381 | 12.051 | 122.151 | 47.348 | 1.00 | 31.54 | | O |
| ANISOU | 2465 | O | MET | A | 381 | 4107 | 3793 | 4085 | −445 | −513 | 327 | O |
| ATOM | 2466 | CB | MET | A | 381 | 12.726 | 125.142 | 46.697 | 1.00 | 33.90 | | C |
| ANISOU | 2466 | CB | MET | A | 381 | 4509 | 3783 | 4586 | −558 | −469 | 402 | C |
| ATOM | 2467 | CG | MET | A | 381 | 13.515 | 126.455 | 46.761 | 1.00 | 49.05 | | C |
| ANISOU | 2467 | CG | MET | A | 381 | 6413 | 5553 | 6672 | −645 | −435 | 412 | C |
| ATOM | 2468 | SD | MET | A | 381 | 13.516 | 127.375 | 45.211 | 1.00 | 83.73 | | S |
| ANISOU | 2468 | SD | MET | A | 381 | 11012 | 9774 | 11025 | −681 | −305 | 561 | S |
| ATOM | 2469 | CE | MET | A | 381 | 15.171 | 127.059 | 44.617 | 1.00 | 44.93 | | C |
| ANISOU | 2469 | CE | MET | A | 381 | 6015 | 4815 | 6244 | −807 | −61 | 613 | C |
| ATOM | 2470 | N | CYS | A | 382 | 10.493 | 123.457 | 48.301 | 1.00 | 23.82 | | N |
| ANISOU | 2470 | N | CYS | A | 382 | 3180 | 2742 | 3127 | −378 | −657 | 239 | N |
| ATOM | 2471 | CA | CYS | A | 382 | 9.442 | 122.483 | 48.190 | 1.00 | 21.68 | | C |
| ANISOU | 2471 | CA | CYS | A | 382 | 2919 | 2553 | 2766 | −304 | −676 | 225 | C |
| ATOM | 2472 | C | CYS | A | 382 | 8.278 | 123.012 | 47.348 | 1.00 | 29.19 | | C |
| ANISOU | 2472 | C | CYS | A | 382 | 3952 | 3425 | 3713 | −241 | −735 | 258 | C |
| ATOM | 2473 | O | CYS | A | 382 | 7.976 | 124.202 | 47.372 | 1.00 | 32.15 | | O |
| ANISOU | 2473 | O | CYS | A | 382 | 4364 | 3689 | 4163 | −233 | −781 | 253 | O |
| ATOM | 2474 | CB | CYS | A | 382 | 8.965 | 122.087 | 49.581 | 1.00 | 26.27 | | C |
| ANISOU | 2474 | CB | CYS | A | 382 | 3448 | 3192 | 3343 | −276 | −701 | 118 | C |
| ATOM | 2475 | SG | CYS | A | 382 | 7.675 | 120.800 | 49.598 | 1.00 | 29.80 | | S |
| ANISOU | 2475 | SG | CYS | A | 382 | 3874 | 3721 | 3726 | −202 | −687 | 88 | S |
| ATOM | 2476 | N | VAL | A | 383 | 7.629 | 122.121 | 46.599 | 1.00 | 24.94 | | N |
| ANISOU | 2476 | N | VAL | A | 383 | 3445 | 2930 | 3103 | −193 | −758 | 286 | N |
| ATOM | 2477 | CA | VAL | A | 383 | 6.386 | 122.439 | 45.902 | 1.00 | 22.44 | | C |
| ANISOU | 2477 | CA | VAL | A | 383 | 3186 | 2532 | 2807 | −116 | −874 | 296 | C |
| ATOM | 2478 | C | VAL | A | 383 | 5.395 | 121.311 | 46.150 | 1.00 | 33.43 | | C |
| ANISOU | 2478 | C | VAL | A | 383 | 4490 | 3998 | 4213 | −60 | −907 | 231 | C |
| ATOM | 2479 | O | VAL | A | 383 | 5.794 | 120.188 | 46.483 | 1.00 | 29.56 | | O |
| ANISOU | 2479 | O | VAL | A | 383 | 3952 | 3620 | 3661 | −85 | −831 | 216 | O |
| ATOM | 2480 | CB | VAL | A | 383 | 6.578 | 122.635 | 44.353 | 1.00 | 33.64 | | C |
| ANISOU | 2480 | CB | VAL | A | 383 | 4796 | 3870 | 4118 | −115 | −912 | 414 | C |
| ATOM | 2481 | CG1 | VAL | A | 383 | 7.539 | 123.812 | 44.012 | 1.00 | 24.42 | | C |
| ANISOU | 2481 | CG1 | VAL | A | 383 | 3732 | 2596 | 2950 | −182 | −843 | 492 | C |
| ATOM | 2482 | CG2 | VAL | A | 383 | 7.032 | 121.341 | 43.702 | 1.00 | 22.91 | | C |
| ANISOU | 2482 | CG2 | VAL | A | 383 | 3482 | 2602 | 2621 | −132 | −845 | 451 | C |
| ATOM | 2483 | N | LYS | A | 384 | 4.104 | 121.596 | 45.996 | 1.00 | 32.50 | | N |
| ANISOU | 2483 | N | LYS | A | 384 | 4339 | 3801 | 4207 | 16 | −1021 | 188 | N |
| ATOM | 2484 | CA | LYS | A | 384 | 3.088 | 120.570 | 46.215 | 1.00 | 29.46 | | C |
| ANISOU | 2484 | CA | LYS | A | 384 | 3842 | 3458 | 3894 | 62 | −1043 | 115 | C |
| ATOM | 2485 | C | LYS | A | 384 | 2.443 | 120.130 | 44.912 | 1.00 | 28.24 | | C |
| ANISOU | 2485 | C | LYS | A | 384 | 3758 | 3253 | 3721 | 115 | −1208 | 156 | C |
| ATOM | 2486 | O | LYS | A | 384 | 2.309 | 120.927 | 43.982 | 1.00 | 24.90 | | O |
| ANISOU | 2486 | O | LYS | A | 384 | 3468 | 2716 | 3278 | 148 | −1347 | 218 | O |
| ATOM | 2487 | CB | LYS | A | 384 | 2.023 | 121.065 | 47.202 | 1.00 | 34.78 | | C |
| ANISOU | 2487 | CB | LYS | A | 384 | 4373 | 4068 | 4774 | 107 | −1026 | 1 | C |
| ATOM | 2488 | CG | LYS | A | 384 | 2.501 | 121.046 | 48.659 | 1.00 | 32.63 | | C |
| ANISOU | 2488 | CG | LYS | A | 384 | 4059 | 3861 | 4476 | 57 | −850 | −65 | C |
| ATOM | 2489 | CD | LYS | A | 384 | 1.467 | 121.605 | 49.627 | 1.00 | 32.10 | | C |
| ANISOU | 2489 | CD | LYS | A | 384 | 3892 | 3710 | 4596 | 98 | −783 | −186 | C |
| ATOM | 2490 | CE | LYS | A | 384 | 1.923 | 121.477 | 51.083 | 1.00 | 30.34 | | C |
| ANISOU | 2490 | CE | LYS | A | 384 | 3698 | 3540 | 4290 | 50 | −609 | −255 | C |
| ATOM | 2491 | NZ | LYS | A | 384 | 1.215 | 122.471 | 51.954 | 1.00 | 41.32 | | N |
| ANISOU | 2491 | NZ | LYS | A | 384 | 5058 | 4816 | 5824 | 81 | −530 | −366 | N |
| ATOM | 2492 | N | ILE | A | 385 | 2.071 | 118.851 | 44.828 | 1.00 | 22.52 | | N |
| ANISOU | 2492 | N | ILE | A | 385 | 2971 | 2595 | 2988 | 122 | −1205 | 123 | N |
| ATOM | 2493 | CA | ILE | A | 385 | 1.323 | 118.382 | 43.664 | 1.00 | 34.04 | | C |
| ANISOU | 2493 | CA | ILE | A | 385 | 4494 | 3990 | 4451 | 178 | −1399 | 135 | C |
| ATOM | 2494 | C | ILE | A | 385 | −0.053 | 117.878 | 44.100 | 1.00 | 31.92 | | C |
| ANISOU | 2494 | C | ILE | A | 385 | 4013 | 3681 | 4435 | 229 | −1466 | 19 | C |
| ATOM | 2495 | O | ILE | A | 385 | −0.577 | 118.336 | 45.108 | 1.00 | 41.97 | | O |
| ANISOU | 2495 | O | ILE | A | 385 | 5125 | 4926 | 5896 | 239 | −1379 | −59 | O |
| ATOM | 2496 | CB | ILE | A | 385 | 2.104 | 117.297 | 42.874 | 1.00 | 33.05 | | C |
| ANISOU | 2496 | CB | ILE | A | 385 | 4510 | 3946 | 4103 | 141 | −1363 | 196 | C |
| ATOM | 2497 | CG1 | ILE | A | 385 | 2.475 | 116.101 | 43.756 | 1.00 | 30.00 | | C |
| ANISOU | 2497 | CG1 | ILE | A | 385 | 3994 | 3697 | 3709 | 94 | −1185 | 152 | C |
| ATOM | 2498 | CG2 | ILE | A | 385 | 3.330 | 117.917 | 42.219 | 1.00 | 23.09 | | C |
| ANISOU | 2498 | CG2 | ILE | A | 385 | 3460 | 2674 | 2639 | 96 | −1292 | 307 | C |
| ATOM | 2499 | CD1 | ILE | A | 385 | 3.332 | 115.046 | 43.044 | 1.00 | 24.75 | | C |
| ANISOU | 2499 | CD1 | ILE | A | 385 | 3450 | 3103 | 2849 | 62 | −1127 | 204 | C |
| ATOM | 2500 | N | VAL | A | 386 | −0.628 | 116.946 | 43.352 | 1.00 | 32.79 | | N |
| ANISOU | 2500 | N | VAL | A | 386 | 4124 | 3771 | 4564 | 258 | −1604 | 1 | N |
| ATOM | 2501 | CA | VAL | A | 386 | −1.989 | 116.473 | 43.608 | 1.00 | 42.57 | | C |
| ANISOU | 2501 | CA | VAL | A | 386 | 5138 | 4937 | 6099 | 303 | −1689 | −115 | C |
| ATOM | 2502 | C | VAL | A | 386 | −2.162 | 116.039 | 45.075 | 1.00 | 42.65 | | C |
| ANISOU | 2502 | C | VAL | A | 386 | 4945 | 5018 | 6243 | 258 | −1417 | −197 | C |
| ATOM | 2503 | O | VAL | A | 386 | −1.203 | 115.585 | 45.705 | 1.00 | 36.52 | | O |
| ANISOU | 2503 | O | VAL | A | 386 | 4228 | 4370 | 5278 | 192 | −1215 | −160 | O |
| ATOM | 2504 | CB | VAL | A | 386 | −2.348 | 115.313 | 42.637 | 1.00 | 55.62 | | C |
| ANISOU | 2504 | CB | VAL | A | 386 | 6837 | 6577 | 7718 | 318 | −1859 | −125 | C |
| ATOM | 2505 | CG1 | VAL | A | 386 | −3.751 | 114.792 | 42.881 | 1.00 | 50.22 | | C |
| ANISOU | 2505 | CG1 | VAL | A | 386 | 5888 | 5798 | 7396 | 356 | −1953 | −253 | C |
| ATOM | 2506 | CG2 | VAL | A | 386 | −2.258 | 115.805 | 41.217 | 1.00 | 63.73 | | C |
| ANISOU | 2506 | CG2 | VAL | A | 386 | 8125 | 7505 | 8585 | 370 | −2136 | −49 | C |
| ATOM | 2507 | N | ASP | A | 387 | −3.376 | 116.231 | 45.606 | 1.00 | 46.31 | | N |
| ANISOU | 2507 | N | ASP | A | 387 | 5182 | 5375 | 7037 | 296 | −1413 | −309 | N |
| ATOM | 2508 | CA | ASP | A | 387 | −3.711 | 115.984 | 47.015 | 1.00 | 54.80 | | C |
| ANISOU | 2508 | CA | ASP | A | 387 | 6096 | 6473 | 8254 | 258 | −1126 | −396 | C |
| ATOM | 2509 | C | ASP | A | 387 | −2.633 | 116.423 | 48.003 | 1.00 | 48.74 | | C |
| ANISOU | 2509 | C | ASP | A | 387 | 5455 | 5808 | 7257 | 202 | −905 | −354 | C |
| ATOM | 2510 | O | ASP | A | 387 | −2.343 | 115.710 | 48.963 | 1.00 | 46.21 | | O |
| ANISOU | 2510 | O | ASP | A | 387 | 5138 | 5564 | 6855 | 146 | −683 | −371 | O |
| ATOM | 2511 | CB | ASP | A | 387 | −4.020 | 114.494 | 47.247 | 1.00 | 61.49 | | C |
| ANISOU | 2511 | CB | ASP | A | 387 | 6850 | 7365 | 9148 | 214 | −1017 | −435 | C |
| ATOM | 2512 | CG | ASP | A | 387 | −5.163 | 113.980 | 46.372 | 1.00 | 76.33 | | C |
| ANISOU | 2512 | CG | ASP | A | 387 | 8571 | 9124 | 11307 | 261 | −1243 | −503 | C |
| ATOM | 2513 | OD1 | ASP | A | 387 | −6.292 | 114.513 | 46.493 | 1.00 | 84.81 | | O |
| ANISOU | 2513 | OD1 | ASP | A | 387 | 9433 | 10048 | 12744 | 312 | −1300 | −603 | O |
| ATOM | 2514 | OD2 | ASP | A | 387 | −4.941 | 113.037 | 45.574 | 1.00 | 74.64 | | O |
| ANISOU | 2514 | OD2 | ASP | A | 387 | 8436 | 8950 | 10972 | 249 | −1372 | −467 | O |
| ATOM | 2515 | N | GLY | A | 388 | −2.064 | 117.603 | 47.772 | 1.00 | 36.50 | | N |
| ANISOU | 2515 | N | GLY | A | 388 | 4020 | 4238 | 5611 | 218 | −984 | −300 | N |
| ATOM | 2516 | CA | GLY | A | 388 | −1.130 | 118.206 | 48.703 | 1.00 | 35.71 | | C |
| ANISOU | 2516 | CA | GLY | A | 388 | 4020 | 4198 | 5348 | 172 | −820 | −281 | C |
| ATOM | 2517 | C | GLY | A | 388 | 0.162 | 117.441 | 48.961 | 1.00 | 35.20 | | C |
| ANISOU | 2517 | C | GLY | A | 388 | 4088 | 4283 | 5006 | 100 | −725 | −208 | C |
| ATOM | 2518 | O | GLY | A | 388 | 0.796 | 117.638 | 49.993 | 1.00 | 42.33 | | O |
| ANISOU | 2518 | O | GLY | A | 388 | 5047 | 5229 | 5807 | 59 | −586 | −220 | O |
| ATOM | 2519 | N | VAL | A | 389 | 0.558 | 116.578 | 48.031 | 1.00 | 30.05 | | N |
| ANISOU | 2519 | N | VAL | A | 389 | 3490 | 3691 | 4238 | 91 | −813 | −139 | N |
| ATOM | 2520 | CA | VAL | A | 389 | 1.810 | 115.830 | 48.156 | 1.00 | 27.36 | | C |
| ANISOU | 2520 | CA | VAL | A | 389 | 3249 | 3471 | 3674 | 34 | −735 | −73 | C |
| ATOM | 2521 | C | VAL | A | 389 | 3.034 | 116.740 | 47.958 | 1.00 | 31.63 | | C |
| ANISOU | 2521 | C | VAL | A | 389 | 3908 | 4029 | 4081 | 4 | −753 | 1 | C |
| ATOM | 2522 | O | VAL | A | 389 | 3.088 | 117.510 | 46.988 | 1.00 | 20.32 | | O |
| ANISOU | 2522 | O | VAL | A | 389 | 2545 | 2533 | 2642 | 24 | −867 | 52 | O |
| ATOM | 2523 | CB | VAL | A | 389 | 1.848 | 114.669 | 47.143 | 1.00 | 25.67 | | C |
| ANISOU | 2523 | CB | VAL | A | 389 | 3062 | 3296 | 3395 | 37 | −809 | −34 | C |
| ATOM | 2524 | CG1 | VAL | A | 389 | 3.245 | 114.089 | 47.036 | 1.00 | 22.92 | | C |
| ANISOU | 2524 | CG1 | VAL | A | 389 | 2815 | 3049 | 2845 | −10 | −743 | 40 | C |
| ATOM | 2525 | CG2 | VAL | A | 389 | 0.840 | 113.607 | 47.553 | 1.00 | 26.93 | | C |
| ANISOU | 2525 | CG2 | VAL | A | 389 | 3093 | 3445 | 3695 | 43 | −755 | −109 | C |
| ATOM | 2526 | N | GLN | A | 390 | 4.002 | 116.634 | 48.876 | 1.00 | 25.08 | | N |
| ANISOU | 2526 | N | GLN | A | 390 | 3109 | 3266 | 3155 | −45 | −648 | 5 | N |
| ATOM | 2527 | CA | GLN | A | 390 | 5.161 | 117.521 | 48.929 | 1.00 | 25.41 | | C |
| ANISOU | 2527 | CA | GLN | A | 390 | 3218 | 3305 | 3131 | −84 | −654 | 50 | C |
| ATOM | 2528 | C | GLN | A | 390 | 6.323 | 117.002 | 48.088 | 1.00 | 31.04 | | C |
| ANISOU | 2528 | C | GLN | A | 390 | 3983 | 4071 | 3739 | −119 | −653 | 135 | C |
| ATOM | 2529 | O | GLN | A | 390 | 6.618 | 115.817 | 48.081 | 1.00 | 31.29 | | O |
| ANISOU | 2529 | O | GLN | A | 390 | 4001 | 4175 | 3713 | −126 | −614 | 144 | O |
| ATOM | 2530 | CB | GLN | A | 390 | 5.634 | 117.727 | 50.374 | 1.00 | 24.58 | | C |
| ANISOU | 2530 | CB | GLN | A | 390 | 3121 | 3218 | 3000 | −115 | −583 | −5 | C |
| ATOM | 2531 | CG | GLN | A | 390 | 4.577 | 118.232 | 51.367 | 1.00 | 30.85 | | C |
| ANISOU | 2531 | CG | GLN | A | 390 | 3896 | 3948 | 3879 | −88 | −522 | −103 | C |
| ATOM | 2532 | CD | GLN | A | 390 | 3.824 | 117.090 | 52.048 | 1.00 | 29.29 | | C |
| ANISOU | 2532 | CD | GLN | A | 390 | 3672 | 3778 | 3680 | −78 | −411 | −155 | C |
| ATOM | 2533 | OE1 | GLN | A | 390 | 3.967 | 115.933 | 51.665 | 1.00 | 23.47 | | O |
| ANISOU | 2533 | OE1 | GLN | A | 390 | 2920 | 3106 | 2894 | −84 | −409 | −114 | O |
| ATOM | 2534 | NE2 | GLN | A | 390 | 3.053 | 117.413 | 53.081 | 1.00 | 23.56 | | N |
| ANISOU | 2534 | NE2 | GLN | A | 390 | 2953 | 2990 | 3008 | −67 | −295 | −246 | N |
| ATOM | 2535 | N | CYS | A | 391 | 6.984 | 117.919 | 47.394 | 1.00 | 31.69 | | N |
| ANISOU | 2535 | N | CYS | A | 391 | 4128 | 4102 | 3811 | −142 | −674 | 194 | N |
| ATOM | 2536 | CA | CYS | A | 391 | 8.100 | 117.595 | 46.522 | 1.00 | 30.25 | | C |
| ANISOU | 2536 | CA | CYS | A | 391 | 4001 | 3938 | 3556 | −182 | −623 | 270 | C |
| ATOM | 2537 | C | CYS | A | 391 | 9.262 | 118.531 | 46.825 | 1.00 | 34.03 | | C |
| ANISOU | 2537 | C | CYS | A | 391 | 4469 | 4377 | 4085 | −244 | −579 | 291 | C |
| ATOM | 2538 | O | CYS | A | 391 | 9.100 | 119.753 | 46.737 | 1.00 | 32.48 | | O |
| ANISOU | 2538 | O | CYS | A | 391 | 4311 | 4092 | 3936 | −250 | −612 | 300 | O |
| ATOM | 2539 | CB | CYS | A | 391 | 7.706 | 117.737 | 45.048 | 1.00 | 28.44 | | C |
| ANISOU | 2539 | CB | CYS | A | 391 | 3903 | 3644 | 3257 | −156 | −667 | 335 | C |
| ATOM | 2540 | SG | CYS | A | 391 | 6.292 | 116.771 | 44.490 | 1.00 | 30.99 | | S |
| ANISOU | 2540 | SG | CYS | A | 391 | 4240 | 3973 | 3560 | −82 | −782 | 301 | S |
| ATOM | 2541 | N | TRP | A | 392 | 10.422 | 117.967 | 47.165 | 1.00 | 28.41 | | N |
| ANISOU | 2541 | N | TRP | A | 392 | 3691 | 3712 | 3390 | −287 | −517 | 293 | N |
| ATOM | 2542 | CA | TRP | A | 392 | 11.604 | 118.768 | 47.465 | 1.00 | 20.25 | | C |
| ANISOU | 2542 | CA | TRP | A | 392 | 2609 | 2627 | 2460 | −352 | −490 | 298 | C |
| ATOM | 2543 | C | TRP | A | 392 | 12.622 | 118.712 | 46.326 | 1.00 | 32.49 | | C |
| ANISOU | 2543 | C | TRP | A | 392 | 4174 | 4135 | 4035 | −402 | −360 | 372 | C |
| ATOM | 2544 | O | TRP | A | 392 | 12.675 | 117.738 | 45.568 | 1.00 | 27.38 | | O |
| ANISOU | 2544 | O | TRP | A | 392 | 3564 | 3528 | 3312 | −385 | −288 | 403 | O |
| ATOM | 2545 | CB | TRP | A | 392 | 12.265 | 118.292 | 48.756 | 1.00 | 20.07 | | C |
| ANISOU | 2545 | CB | TRP | A | 392 | 2485 | 2650 | 2490 | −366 | −542 | 234 | C |
| ATOM | 2546 | CG | TRP | A | 392 | 11.521 | 118.608 | 49.999 | 1.00 | 19.86 | | C |
| ANISOU | 2546 | CG | TRP | A | 392 | 2486 | 2627 | 2433 | −338 | −630 | 157 | C |
| ATOM | 2547 | CD1 | TRP | A | 392 | 11.709 | 119.693 | 50.823 | 1.00 | 24.24 | | C |
| ANISOU | 2547 | CD1 | TRP | A | 392 | 3049 | 3114 | 3046 | −363 | −696 | 104 | C |
| ATOM | 2548 | CD2 | TRP | A | 392 | 10.483 | 117.828 | 50.598 | 1.00 | 19.39 | | C |
| ANISOU | 2548 | CD2 | TRP | A | 392 | 2462 | 2625 | 2281 | −285 | −637 | 115 | C |
| ATOM | 2549 | NE1 | TRP | A | 392 | 10.839 | 119.636 | 51.885 | 1.00 | 20.39 | | N |
| ANISOU | 2549 | NE1 | TRP | A | 392 | 2625 | 2640 | 2484 | −324 | −729 | 30 | N |
| ATOM | 2550 | CE2 | TRP | A | 392 | 10.068 | 118.508 | 51.766 | 1.00 | 23.07 | | C |
| ANISOU | 2550 | CE2 | TRP | A | 392 | 2975 | 3052 | 2739 | −279 | −679 | 39 | C |
| ATOM | 2551 | CE3 | TRP | A | 392 | 9.843 | 116.635 | 50.247 | 1.00 | 20.12 | | C |
| ANISOU | 2551 | CE3 | TRP | A | 392 | 2557 | 2782 | 2306 | −246 | −597 | 130 | C |
| ATOM | 2552 | CZ2 | TRP | A | 392 | 9.054 | 118.017 | 52.598 | 1.00 | 31.95 | | C |
| ANISOU | 2552 | CZ2 | TRP | A | 392 | 4154 | 4197 | 3791 | −240 | −646 | −19 | C |
| ATOM | 2553 | CZ3 | TRP | A | 392 | 8.838 | 116.147 | 51.076 | 1.00 | 19.65 | | C |
| ANISOU | 2553 | CZ3 | TRP | A | 392 | 2525 | 2742 | 2198 | −212 | −583 | 75 | C |
| ATOM | 2554 | CH2 | TRP | A | 392 | 8.461 | 116.829 | 52.242 | 1.00 | 22.51 | | C |
| ANISOU | 2554 | CH2 | TRP | A | 392 | 2940 | 3061 | 2553 | −210 | −590 | 4 | C |
| ATOM | 2555 | N | LYS | A | 393 | 13.436 | 119.757 | 46.221 | 1.00 | 28.75 | | N |
| ANISOU | 2555 | N | LYS | A | 393 | 3680 | 3567 | 3678 | −468 | −311 | 393 | N |
| ATOM | 2556 | CA | LYS | A | 393 | 14.509 | 119.803 | 45.235 | 1.00 | 32.19 | | C |
| ANISOU | 2556 | CA | LYS | A | 393 | 4120 | 3934 | 4177 | −532 | −132 | 456 | C |
| ATOM | 2557 | C | LYS | A | 393 | 15.570 | 118.763 | 45.522 | 1.00 | 30.02 | | C |
| ANISOU | 2557 | C | LYS | A | 393 | 3681 | 3708 | 4017 | −551 | −71 | 423 | C |
| ATOM | 2558 | O | LYS | A | 393 | 16.187 | 118.221 | 44.605 | 1.00 | 29.41 | | O |
| ANISOU | 2558 | O | LYS | A | 393 | 3615 | 3608 | 3949 | −572 | 105 | 463 | O |
| ATOM | 2559 | CB | LYS | A | 393 | 15.168 | 121.183 | 45.204 | 1.00 | 38.96 | | C |
| ANISOU | 2559 | CB | LYS | A | 393 | 4960 | 4658 | 5184 | −612 | −83 | 477 | C |
| ATOM | 2560 | CG | LYS | A | 393 | 14.429 | 122.202 | 44.374 | 1.00 | 40.34 | | C |
| ANISOU | 2560 | CG | LYS | A | 393 | 5339 | 4734 | 5252 | −606 | −70 | 550 | C |
| ATOM | 2561 | CD | LYS | A | 393 | 15.162 | 123.522 | 44.341 | 1.00 | 47.20 | | C |
| ANISOU | 2561 | CD | LYS | A | 393 | 6193 | 5456 | 6286 | −695 | 1 | 576 | C |
| ATOM | 2562 | CE | LYS | A | 393 | 16.397 | 123.460 | 43.450 | 1.00 | 53.58 | | C |
| ANISOU | 2562 | CE | LYS | A | 393 | 6990 | 6172 | 7195 | −787 | 262 | 637 | C |
| ATOM | 2563 | NZ | LYS | A | 393 | 16.986 | 124.812 | 43.215 | 1.00 | 56.76 | | N |
| ANISOU | 2563 | NZ | LYS | A | 393 | 7415 | 6398 | 7752 | −883 | 365 | 680 | N |
| ATOM | 2564 | N | TYR | A | 394 | 15.826 | 118.537 | 46.804 | 1.00 | 23.00 | | N |
| ANISOU | 2564 | N | TYR | A | 394 | 2653 | 2863 | 3222 | −541 | −217 | 348 | N |
| ATOM | 2565 | CA | TYR | A | 394 | 16.906 | 117.643 | 47.198 | 1.00 | 26.73 | | C |
| ANISOU | 2565 | CA | TYR | A | 394 | 2956 | 3355 | 3847 | −550 | −213 | 311 | C |
| ATOM | 2566 | C | TYR | A | 394 | 16.489 | 116.642 | 48.266 | 1.00 | 26.01 | | C |
| ANISOU | 2566 | C | TYR | A | 394 | 2849 | 3362 | 3672 | −483 | −379 | 258 | C |
| ATOM | 2567 | O | TYR | A | 394 | 15.550 | 116.880 | 49.023 | 1.00 | 25.42 | | O |
| ANISOU | 2567 | O | TYR | A | 394 | 2864 | 3324 | 3472 | −448 | −499 | 228 | O |
| ATOM | 2568 | CB | TYR | A | 394 | 18.101 | 118.456 | 47.700 | 1.00 | 26.35 | | C |
| ANISOU | 2568 | CB | TYR | A | 394 | 2738 | 3201 | 4073 | −625 | −244 | 273 | C |
| ATOM | 2569 | CG | TYR | A | 394 | 18.465 | 119.647 | 46.849 | 1.00 | 26.26 | | C |
| ANISOU | 2569 | CG | TYR | A | 394 | 2753 | 3065 | 4161 | −707 | −80 | 323 | C |
| ATOM | 2570 | CD1 | TYR | A | 394 | 18.965 | 119.483 | 45.565 | 1.00 | 28.09 | | C |
| ANISOU | 2570 | CD1 | TYR | A | 394 | 3012 | 3237 | 4423 | −748 | 187 | 390 | C |
| ATOM | 2571 | CD2 | TYR | A | 394 | 18.356 | 120.938 | 47.348 | 1.00 | 31.56 | | C |
| ANISOU | 2571 | CD2 | TYR | A | 394 | 3439 | 3658 | 4895 | −747 | −174 | 303 | C |
| ATOM | 2572 | CE1 | TYR | A | 394 | 19.329 | 120.585 | 44.781 | 1.00 | 28.83 | | C |
| ANISOU | 2572 | CE1 | TYR | A | 394 | 3166 | 3192 | 4597 | −832 | 368 | 448 | C |
| ATOM | 2573 | CE2 | TYR | A | 394 | 18.723 | 122.059 | 46.573 | 1.00 | 29.46 | | C |
| ANISOU | 2573 | CE2 | TYR | A | 394 | 3206 | 3255 | 4732 | −830 | −15 | 357 | C |
| ATOM | 2574 | CZ | TYR | A | 394 | 19.201 | 121.866 | 45.295 | 1.00 | 31.26 | | C |
| ANISOU | 2574 | CZ | TYR | A | 394 | 3477 | 3422 | 4978 | −873 | 259 | 436 | C |
| ATOM | 2575 | OH | TYR | A | 394 | 19.547 | 122.952 | 44.530 | 1.00 | 35.26 | | O |
| ANISOU | 2575 | OH | TYR | A | 394 | 4058 | 3775 | 5565 | −959 | 442 | 501 | O |
| ATOM | 2576 | N | LEU | A | 395 | 17.214 | 115.532 | 48.346 | 1.00 | 29.22 | | N |
| ANISOU | 2576 | N | LEU | A | 395 | 3147 | 3793 | 4161 | −465 | −370 | 245 | N |
| ATOM | 2577 | CA | LEU | A | 395 | 16.986 | 114.550 | 49.403 | 1.00 | 29.60 | | C |
| ANISOU | 2577 | CA | LEU | A | 395 | 3198 | 3908 | 4142 | −405 | −531 | 204 | C |
| ATOM | 2578 | C | LEU | A | 395 | 17.590 | 115.022 | 50.712 | 1.00 | 31.53 | | C |
| ANISOU | 2578 | C | LEU | A | 395 | 3380 | 4100 | 4499 | −418 | −741 | 140 | C |
| ATOM | 2579 | O | LEU | A | 395 | 17.183 | 114.588 | 51.790 | 1.00 | 33.50 | | O |
| ANISOU | 2579 | O | LEU | A | 395 | 3718 | 4383 | 4628 | −374 | −896 | 107 | O |
| ATOM | 2580 | CB | LEU | A | 395 | 17.589 | 113.206 | 49.029 | 1.00 | 33.69 | | C |
| ANISOU | 2580 | CB | LEU | A | 395 | 3629 | 4448 | 4724 | −373 | −468 | 212 | C |
| ATOM | 2581 | CG | LEU | A | 395 | 17.012 | 112.413 | 47.864 | 1.00 | 31.58 | | C |
| ANISOU | 2581 | CG | LEU | A | 395 | 3450 | 4231 | 4318 | −347 | −295 | 257 | C |
| ATOM | 2582 | CD1 | LEU | A | 395 | 17.914 | 111.217 | 47.633 | 1.00 | 25.29 | | C |
| ANISOU | 2582 | CD1 | LEU | A | 395 | 2531 | 3424 | 3655 | −322 | −236 | 246 | C |
| ATOM | 2583 | CD2 | LEU | A | 395 | 15.605 | 111.963 | 48.165 | 1.00 | 30.36 | | C |
| ANISOU | 2583 | CD2 | LEU | A | 395 | 3447 | 4157 | 3933 | −297 | −363 | 260 | C |
| ATOM | 2584 | N | GLU | A | 396 | 18.558 | 115.924 | 50.604 | 1.00 | 34.28 | | N |
| ANISOU | 2584 | N | GLU | A | 396 | 3597 | 4351 | 5077 | −483 | −742 | 122 | N |
| ATOM | 2585 | CA | GLU | A | 396 | 19.307 | 116.395 | 51.758 | 1.00 | 39.12 | | C |
| ANISOU | 2585 | CA | GLU | A | 396 | 4132 | 4887 | 5844 | −501 | −974 | 48 | C |
| ATOM | 2586 | C | GLU | A | 396 | 18.458 | 117.185 | 52.747 | 1.00 | 38.84 | | C |
| ANISOU | 2586 | C | GLU | A | 396 | 4277 | 4855 | 5625 | −492 | −1118 | 6 | C |
| ATOM | 2587 | O | GLU | A | 396 | 17.751 | 118.129 | 52.382 | 1.00 | 44.98 | | O |
| ANISOU | 2587 | O | GLU | A | 396 | 5139 | 5627 | 6325 | −516 | −1024 | 22 | O |
| ATOM | 2588 | CB | GLU | A | 396 | 20.507 | 117.226 | 51.302 | 1.00 | 50.76 | | C |
| ANISOU | 2588 | CB | GLU | A | 396 | 5397 | 6235 | 7655 | −585 | −918 | 31 | C |
| ATOM | 2589 | CG | GLU | A | 396 | 21.312 | 117.813 | 52.449 | 1.00 | 64.11 | | C |
| ANISOU | 2589 | CG | GLU | A | 396 | 6991 | 7820 | 9545 | −611 | −1195 | −60 | C |
| ATOM | 2590 | CD | GLU | A | 396 | 22.661 | 118.361 | 52.009 | 1.00 | 77.02 | | C |
| ANISOU | 2590 | CD | GLU | A | 396 | 8348 | 9311 | 11605 | −696 | −1142 | −89 | C |
| ATOM | 2591 | OE1 | GLU | A | 396 | 23.061 | 118.110 | 50.851 | 1.00 | 80.67 | | O |
| ANISOU | 2591 | OE1 | GLU | A | 396 | 8692 | 9755 | 12203 | −729 | −862 | −36 | O |
| ATOM | 2592 | OE2 | GLU | A | 396 | 23.306 | 119.070 | 52.814 | 1.00 | 82.27 | | O |
| ANISOU | 2592 | OE2 | GLU | A | 396 | 8921 | 9865 | 12474 | −734 | −1370 | −170 | O |
| ATOM | 2593 | N | GLY | A | 397 | 18.553 | 116.801 | 54.014 | 1.00 | 35.83 | | N |
| ANISOU | 2593 | N | GLY | A | 397 | 3973 | 4466 | 5176 | −453 | −1348 | −52 | N |
| ATOM | 2594 | CA | GLY | A | 397 | 17.802 | 117.453 | 55.067 | 1.00 | 38.44 | | C |
| ANISOU | 2594 | CA | GLY | A | 397 | 4508 | 4783 | 5313 | −441 | −1466 | −107 | C |
| ATOM | 2595 | C | GLY | A | 397 | 16.562 | 116.691 | 55.503 | 1.00 | 36.05 | | C |
| ANISOU | 2595 | C | GLY | A | 397 | 4416 | 4570 | 4712 | −378 | −1410 | −92 | C |
| ATOM | 2596 | O | GLY | A | 397 | 16.144 | 116.812 | 56.654 | 1.00 | 38.67 | | O |
| ANISOU | 2596 | O | GLY | A | 397 | 4942 | 4876 | 4873 | −355 | −1525 | −147 | O |
| ATOM | 2597 | N | LEU | A | 398 | 15.994 | 115.881 | 54.612 | 1.00 | 26.77 | | N |
| ANISOU | 2597 | N | LEU | A | 398 | 3213 | 3481 | 3477 | −352 | −1229 | −24 | N |
| ATOM | 2598 | CA | LEU | A | 398 | 14.821 | 115.088 | 54.959 | 1.00 | 23.59 | | C |
| ANISOU | 2598 | CA | LEU | A | 398 | 2971 | 3147 | 2845 | −302 | −1158 | −12 | C |
| ATOM | 2599 | C | LEU | A | 398 | 15.206 | 113.992 | 55.950 | 1.00 | 22.69 | | C |
| ANISOU | 2599 | C | LEU | A | 398 | 2950 | 3025 | 2647 | −261 | −1304 | −22 | C |
| ATOM | 2600 | O | LEU | A | 398 | 16.248 | 113.371 | 55.811 | 1.00 | 24.46 | | O |
| ANISOU | 2600 | O | LEU | A | 398 | 3051 | 3229 | 3013 | −252 | −1401 | −7 | O |
| ATOM | 2601 | CB | LEU | A | 398 | 14.184 | 114.485 | 53.705 | 1.00 | 25.28 | | C |
| ANISOU | 2601 | CB | LEU | A | 398 | 3122 | 3436 | 3045 | −288 | −965 | 54 | C |
| ATOM | 2602 | CG | LEU | A | 398 | 13.242 | 115.346 | 52.842 | 1.00 | 28.10 | | C |
| ANISOU | 2602 | CG | LEU | A | 398 | 3488 | 3801 | 3388 | −301 | −833 | 71 | C |
| ATOM | 2603 | CD1 | LEU | A | 398 | 12.029 | 115.851 | 53.646 | 1.00 | 31.61 | | C |
| ANISOU | 2603 | CD1 | LEU | A | 398 | 4068 | 4233 | 3708 | −281 | −821 | 19 | C |
| ATOM | 2604 | CD2 | LEU | A | 398 | 13.969 | 116.510 | 52.197 | 1.00 | 20.59 | | C |
| ANISOU | 2604 | CD2 | LEU | A | 398 | 2447 | 2786 | 2591 | −354 | −824 | 83 | C |
| ATOM | 2605 | N | PRO | A | 399 | 14.355 | 113.752 | 56.955 | 1.00 | 26.17 | | N |
| ANISOU | 2605 | N | PRO | A | 399 | 3618 | 3462 | 2864 | −234 | −1308 | −47 | N |
| ATOM | 2606 | CA | PRO | A | 399 | 14.645 | 112.810 | 58.039 | 1.00 | 26.34 | | C |
| ANISOU | 2606 | CA | PRO | A | 399 | 3811 | 3446 | 2751 | −195 | −1455 | −51 | C |
| ATOM | 2607 | C | PRO | A | 399 | 14.381 | 111.365 | 57.636 | 1.00 | 28.06 | | C |
| ANISOU | 2607 | C | PRO | A | 399 | 4009 | 3721 | 2931 | −159 | −1359 | 16 | C |
| ATOM | 2608 | O | PRO | A | 399 | 13.621 | 111.120 | 56.695 | 1.00 | 28.22 | | O |
| ANISOU | 2608 | O | PRO | A | 399 | 3941 | 3813 | 2970 | −164 | −1157 | 49 | O |
| ATOM | 2609 | CB | PRO | A | 399 | 13.651 | 113.225 | 59.125 | 1.00 | 26.63 | | C |
| ANISOU | 2609 | CB | PRO | A | 399 | 4130 | 3445 | 2544 | −192 | −1405 | −102 | C |
| ATOM | 2610 | CG | PRO | A | 399 | 12.462 | 113.660 | 58.337 | 1.00 | 28.54 | | C |
| ANISOU | 2610 | CG | PRO | A | 399 | 4295 | 3747 | 2804 | −207 | −1151 | −97 | C |
| ATOM | 2611 | CD | PRO | A | 399 | 12.983 | 114.275 | 57.055 | 1.00 | 22.20 | | C |
| ANISOU | 2611 | CD | PRO | A | 399 | 3230 | 2975 | 2228 | −236 | −1140 | −70 | C |
| ATOM | 2612 | N | ASP | A | 400 | 15.002 | 110.420 | 58.328 | 1.00 | 27.38 | | N |
| ANISOU | 2612 | N | ASP | A | 400 | 4016 | 3589 | 2800 | −120 | −1524 | 33 | N |
| ATOM | 2613 | CA | ASP | A | 400 | 14.596 | 109.024 | 58.183 | 1.00 | 30.25 | | C |
| ANISOU | 2613 | CA | ASP | A | 400 | 4424 | 3984 | 3087 | −85 | −1429 | 92 | C |
| ATOM | 2614 | C | ASP | A | 400 | 13.283 | 108.821 | 58.924 | 1.00 | 30.46 | | C |
| ANISOU | 2614 | C | ASP | A | 400 | 4712 | 4004 | 2859 | −88 | −1272 | 90 | C |
| ATOM | 2615 | O | ASP | A | 400 | 13.069 | 109.402 | 59.979 | 1.00 | 34.00 | | O |
| ANISOU | 2615 | O | ASP | A | 400 | 5390 | 4387 | 3142 | −95 | −1326 | 46 | O |
| ATOM | 2616 | CB | ASP | A | 400 | 15.659 | 108.055 | 58.736 | 1.00 | 26.45 | | C |
| ANISOU | 2616 | CB | ASP | A | 400 | 3977 | 3431 | 2642 | −34 | −1668 | 116 | C |
| ATOM | 2617 | CG | ASP | A | 400 | 16.956 | 108.102 | 57.965 | 1.00 | 31.15 | | C |
| ANISOU | 2617 | CG | ASP | A | 400 | 4268 | 4014 | 3553 | −29 | −1784 | 109 | C |
| ATOM | 2618 | OD1 | ASP | A | 400 | 16.926 | 108.341 | 56.736 | 1.00 | 35.02 | | O |
| ANISOU | 2618 | OD1 | ASP | A | 400 | 4536 | 4573 | 4199 | −59 | −1598 | 118 | O |
| ATOM | 2619 | OD2 | ASP | A | 400 | 18.014 | 107.904 | 58.587 | 1.00 | 43.92 | | O |
| ANISOU | 2619 | OD2 | ASP | A | 400 | 5875 | 5536 | 5276 | 6 | −2044 | 91 | O |
| ATOM | 2620 | N | LEU | A | 401 | 12.396 | 108.009 | 58.371 | 1.00 | 29.93 | | N |
| ANISOU | 2620 | N | LEU | A | 401 | 4611 | 3988 | 2771 | −87 | −1066 | 128 | N |
| ATOM | 2621 | CA | LEU | A | 401 | 11.302 | 107.476 | 59.165 | 1.00 | 33.77 | | C |
| ANISOU | 2621 | CA | LEU | A | 401 | 5337 | 4436 | 3056 | −90 | −910 | 133 | C |
| ATOM | 2622 | C | LEU | A | 401 | 11.751 | 106.126 | 59.743 | 1.00 | 39.47 | | C |
| ANISOU | 2622 | C | LEU | A | 401 | 6214 | 5102 | 3683 | −53 | −1006 | 193 | C |
| ATOM | 2623 | O | LEU | A | 401 | 12.628 | 105.454 | 59.184 | 1.00 | 38.21 | | O |
| ANISOU | 2623 | O | LEU | A | 401 | 5900 | 4957 | 3660 | −21 | −1132 | 230 | O |
| ATOM | 2624 | CB | LEU | A | 401 | 10.029 | 107.325 | 58.331 | 1.00 | 30.41 | | C |
| ANISOU | 2624 | CB | LEU | A | 401 | 4786 | 4069 | 2700 | −114 | −649 | 130 | C |
| ATOM | 2625 | CG | LEU | A | 401 | 9.509 | 108.611 | 57.672 | 1.00 | 32.87 | | C |
| ANISOU | 2625 | CG | LEU | A | 401 | 4947 | 4420 | 3120 | −139 | −573 | 79 | C |
| ATOM | 2626 | CD1 | LEU | A | 401 | 8.219 | 108.367 | 56.867 | 1.00 | 32.55 | | C |
| ANISOU | 2626 | CD1 | LEU | A | 401 | 4785 | 4412 | 3172 | −150 | −369 | 71 | C |
| ATOM | 2627 | CD2 | LEU | A | 401 | 9.298 | 109.706 | 58.700 | 1.00 | 28.45 | | C |
| ANISOU | 2627 | CD2 | LEU | A | 401 | 4563 | 3797 | 2449 | −152 | −576 | 15 | C |
| ATOM | 2628 | N | PHE | A | 402 | 11.148 | 105.718 | 60.850 | 1.00 | 35.66 | | N |
| ANISOU | 2628 | N | PHE | A | 402 | 6046 | 4535 | 2967 | −55 | −931 | 204 | N |
| ATOM | 2629 | CA | PHE | A | 402 | 11.530 | 104.463 | 61.466 | 1.00 | 38.03 | | C |
| ANISOU | 2629 | CA | PHE | A | 402 | 6545 | 4755 | 3148 | −18 | −1028 | 272 | C |
| ATOM | 2630 | C | PHE | A | 402 | 10.329 | 103.551 | 61.645 | 1.00 | 38.09 | | C |
| ANISOU | 2630 | C | PHE | A | 402 | 6690 | 4731 | 3053 | −45 | −739 | 309 | C |
| ATOM | 2631 | O | PHE | A | 402 | 9.354 | 103.892 | 62.311 | 1.00 | 41.10 | | O |
| ANISOU | 2631 | O | PHE | A | 402 | 7269 | 5062 | 3286 | −84 | −523 | 279 | O |
| ATOM | 2632 | CB | PHE | A | 402 | 12.250 | 104.729 | 62.797 | 1.00 | 40.44 | | C |
| ANISOU | 2632 | CB | PHE | A | 402 | 7076 | 4940 | 3347 | 10 | −1215 | 249 | C |
| ATOM | 2633 | CG | PHE | A | 402 | 13.638 | 105.254 | 62.610 | 1.00 | 39.26 | | C |
| ANISOU | 2633 | CG | PHE | A | 402 | 6735 | 4791 | 3391 | 42 | −1513 | 219 | C |
| ATOM | 2634 | CD1 | PHE | A | 402 | 13.868 | 106.618 | 62.484 | 1.00 | 36.35 | | C |
| ANISOU | 2634 | CD1 | PHE | A | 402 | 6268 | 4451 | 3092 | 16 | −1576 | 148 | C |
| ATOM | 2635 | CD2 | PHE | A | 402 | 14.705 | 104.382 | 62.461 | 1.00 | 43.08 | | C |
| ANISOU | 2635 | CD2 | PHE | A | 402 | 7107 | 5238 | 4024 | 94 | −1711 | 256 | C |
| ATOM | 2636 | CE1 | PHE | A | 402 | 15.147 | 107.106 | 62.270 | 1.00 | 33.35 | | C |
| ANISOU | 2636 | CE1 | PHE | A | 402 | 5685 | 4055 | 2932 | 33 | −1822 | 117 | C |
| ATOM | 2637 | CE2 | PHE | A | 402 | 15.988 | 104.860 | 62.245 | 1.00 | 43.91 | | C |
| ANISOU | 2637 | CE2 | PHE | A | 402 | 7001 | 5324 | 4360 | 117 | −1954 | 218 | C |
| ATOM | 2638 | CZ | PHE | A | 402 | 16.211 | 106.230 | 62.149 | 1.00 | 35.62 | | C |
| ANISOU | 2638 | CZ | PHE | A | 402 | 5851 | 4297 | 3385 | 82 | −2002 | 149 | C |
| ATOM | 2639 | N | VAL | A | 403 | 10.397 | 102.409 | 60.978 | 1.00 | 36.46 | | N |
| ANISOU | 2639 | N | VAL | A | 403 | 6349 | 4546 | 2960 | −29 | −715 | 363 | N |
| ATOM | 2640 | CA | VAL | A | 403 | 9.354 | 101.400 | 61.041 | 1.00 | 35.64 | | C |
| ANISOU | 2640 | CA | VAL | A | 403 | 6333 | 4398 | 2812 | −59 | −458 | 400 | C |
| ATOM | 2641 | C | VAL | A | 403 | 9.681 | 100.320 | 62.049 | 1.00 | 34.79 | | C |
| ANISOU | 2641 | C | VAL | A | 403 | 6561 | 4155 | 2503 | −31 | −534 | 481 | C |
| ATOM | 2642 | O | VAL | A | 403 | 10.708 | 99.659 | 61.931 | 1.00 | 34.16 | | O |
| ANISOU | 2642 | O | VAL | A | 403 | 6439 | 4055 | 2486 | 29 | −773 | 525 | O |
| ATOM | 2643 | CB | VAL | A | 403 | 9.152 | 100.740 | 59.702 | 1.00 | 34.79 | | C |
| ANISOU | 2643 | CB | VAL | A | 403 | 5907 | 4373 | 2938 | −62 | −386 | 405 | C |
| ATOM | 2644 | CG1 | VAL | A | 403 | 8.037 | 99.732 | 59.795 | 1.00 | 41.73 | | C |
| ANISOU | 2644 | CG1 | VAL | A | 403 | 6861 | 5188 | 3806 | −102 | −130 | 430 | C |
| ATOM | 2645 | CG2 | VAL | A | 403 | 8.873 | 101.792 | 58.656 | 1.00 | 31.65 | | C |
| ANISOU | 2645 | CG2 | VAL | A | 403 | 5221 | 4090 | 2715 | −82 | −343 | 337 | C |
| ATOM | 2646 | N | THR | A | 404 | 8.823 | 100.163 | 63.052 | 1.00 | 37.38 | | N |
| ANISOU | 2646 | N | THR | A | 404 | 7161 | 4376 | 2664 | −70 | −312 | 481 | N |
| ATOM | 2647 | CA | THR | A | 404 | 8.976 | 99.084 | 64.016 | 1.00 | 39.13 | | C |
| ANISOU | 2647 | CA | THR | A | 404 | 7640 | 4453 | 2774 | −50 | −323 | 538 | C |
| ATOM | 2648 | C | THR | A | 404 | 8.164 | 97.876 | 63.554 | 1.00 | 39.39 | | C |
| ANISOU | 2648 | C | THR | A | 404 | 7657 | 4456 | 2855 | −87 | −86 | 599 | C |
| ATOM | 2649 | O | THR | A | 404 | 6.954 | 97.968 | 63.362 | 1.00 | 47.69 | | O |
| ANISOU | 2649 | O | THR | A | 404 | 8682 | 5505 | 3934 | −159 | 240 | 574 | O |
| ATOM | 2650 | CB | THR | A | 404 | 8.525 | 99.520 | 65.414 | 1.00 | 44.18 | | C |
| ANISOU | 2650 | CB | THR | A | 404 | 8603 | 4964 | 3218 | −75 | −199 | 501 | C |
| ATOM | 2651 | OG1 | THR | A | 404 | 9.352 | 100.600 | 65.859 | 1.00 | 52.55 | | O |
| ANISOU | 2651 | OG1 | THR | A | 404 | 9692 | 6034 | 4242 | −40 | −445 | 445 | O |
| ATOM | 2652 | CG2 | THR | A | 404 | 8.638 | 98.385 | 66.390 | 1.00 | 36.97 | | C |
| ANISOU | 2652 | CG2 | THR | A | 404 | 7990 | 3886 | 2172 | −59 | −204 | 561 | C |
| ATOM | 2653 | N | LEU | A | 405 | 8.849 | 96.757 | 63.350 | 1.00 | 37.10 | | N |
| ANISOU | 2653 | N | LEU | A | 405 | 7360 | 4127 | 2608 | −39 | −250 | 670 | N |
| ATOM | 2654 | CA | LEU | A | 405 | 8.231 | 95.529 | 62.866 | 1.00 | 39.55 | | C |
| ANISOU | 2654 | CA | LEU | A | 405 | 7653 | 4392 | 2982 | −69 | −65 | 733 | C |
| ATOM | 2655 | C | LEU | A | 405 | 7.793 | 94.635 | 64.024 | 1.00 | 48.05 | | C |
| ANISOU | 2655 | C | LEU | A | 405 | 9043 | 5293 | 3922 | −91 | 85 | 773 | C |
| ATOM | 2656 | O | LEU | A | 405 | 7.807 | 95.066 | 65.180 | 1.00 | 47.26 | | O |
| ANISOU | 2656 | O | LEU | A | 405 | 9189 | 5109 | 3658 | −91 | 85 | 744 | O |
| ATOM | 2657 | CB | LEU | A | 405 | 9.200 | 94.790 | 61.955 | 1.00 | 36.04 | | C |
| ANISOU | 2657 | CB | LEU | A | 405 | 7010 | 3991 | 2693 | 1 | −313 | 775 | C |
| ATOM | 2658 | CG | LEU | A | 405 | 9.660 | 95.663 | 60.785 | 1.00 | 37.70 | | C |
| ANISOU | 2658 | CG | LEU | A | 405 | 6810 | 4378 | 3134 | 21 | −427 | 689 | C |
| ATOM | 2659 | CD1 | LEU | A | 405 | 10.686 | 94.938 | 59.944 | 1.00 | 37.23 | | C |
| ANISOU | 2659 | CD1 | LEU | A | 405 | 6530 | 4346 | 3270 | 93 | −633 | 704 | C |
| ATOM | 2660 | CD2 | LEU | A | 405 | 8.494 | 96.117 | 59.912 | 1.00 | 34.57 | | C |
| ANISOU | 2660 | CD2 | LEU | A | 405 | 6162 | 4080 | 2892 | −53 | −158 | 612 | C |
| ATOM | 2661 | N | SER | A | 406 | 7.415 | 93.393 | 63.709 | 1.00 | 54.99 | | N |
| ANISOU | 2661 | N | SER | A | 406 | 9927 | 6101 | 4867 | −112 | 211 | 837 | N |
| ATOM | 2662 | CA | SER | A | 406 | 6.819 | 92.466 | 64.688 | 1.00 | 54.75 | | C |
| ANISOU | 2662 | CA | SER | A | 406 | 10177 | 5895 | 4731 | −150 | 413 | 875 | C |
| ATOM | 2663 | C | SER | A | 406 | 7.711 | 92.134 | 65.878 | 1.00 | 51.50 | | C |
| ANISOU | 2663 | C | SER | A | 406 | 10079 | 5362 | 4128 | −83 | 174 | 906 | C |
| ATOM | 2664 | O | SER | A | 406 | 7.283 | 92.239 | 67.023 | 1.00 | 56.65 | | O |
| ANISOU | 2664 | O | SER | A | 406 | 11028 | 5891 | 4604 | −112 | 312 | 889 | O |
| ATOM | 2665 | CB | SER | A | 406 | 6.423 | 91.148 | 64.008 | 1.00 | 62.83 | | C |
| ANISOU | 2665 | CB | SER | A | 406 | 11116 | 6860 | 5896 | −179 | 543 | 940 | C |
| ATOM | 2666 | OG | SER | A | 406 | 5.181 | 91.249 | 63.341 | 1.00 | 67.80 | | O |
| ANISOU | 2666 | OG | SER | A | 406 | 11554 | 7512 | 6693 | −279 | 883 | 899 | O |
| ATOM | 2667 | N | ASN | A | 407 | 8.950 | 91.742 | 65.604 | 1.00 | 54.16 | | N |
| ANISOU | 2667 | N | ASN | A | 407 | 10348 | 5717 | 4513 | 9 | −184 | 945 | N |
| ATOM | 2668 | CA | ASN | A | 407 | 9.889 | 91.345 | 66.651 | 1.00 | 65.63 | | C |
| ANISOU | 2668 | CA | ASN | A | 407 | 12068 | 7040 | 5826 | 79 | −455 | 971 | C |
| ATOM | 2669 | C | ASN | A | 407 | 10.573 | 92.557 | 67.277 | 1.00 | 73.02 | | C |
| ANISOU | 2669 | C | ASN | A | 407 | 13067 | 8000 | 6676 | 113 | −678 | 900 | C |
| ATOM | 2670 | O | ASN | A | 407 | 11.657 | 92.449 | 67.865 | 1.00 | 72.91 | | O |
| ANISOU | 2670 | O | ASN | A | 407 | 13169 | 7908 | 6624 | 187 | −1005 | 901 | O |
| ATOM | 2671 | CB | ASN | A | 407 | 10.933 | 90.368 | 66.097 | 1.00 | 75.31 | | C |
| ANISOU | 2671 | CB | ASN | A | 407 | 13164 | 8250 | 7198 | 167 | −743 | 1029 | C |
| ATOM | 2672 | CG | ASN | A | 407 | 11.847 | 91.001 | 65.052 | 1.00 | 85.26 | | C |
| ANISOU | 2672 | CG | ASN | A | 407 | 14059 | 9664 | 8674 | 227 | −991 | 990 | C |
| ATOM | 2673 | OD1 | ASN | A | 407 | 11.597 | 92.109 | 64.565 | 1.00 | 82.91 | | O |
| ANISOU | 2673 | OD1 | ASN | A | 407 | 13583 | 9501 | 8417 | 194 | −926 | 930 | O |
| ATOM | 2674 | ND2 | ASN | A | 407 | 12.916 | 90.291 | 64.702 | 1.00 | 91.21 | | N |
| ANISOU | 2674 | ND2 | ASN | A | 407 | 14693 | 10383 | 9581 | 317 | −1268 | 1019 | N |
| ATOM | 2675 | N | ASN | A | 408 | 9.923 | 93.708 | 67.121 | 1.00 | 71.53 | | N |
| ANISOU | 2675 | N | ASN | A | 408 | 12789 | 7908 | 6481 | 58 | −500 | 832 | N |
| ATOM | 2676 | CA | ASN | A | 408 | 10.345 | 94.962 | 67.727 | 1.00 | 66.83 | | C |
| ANISOU | 2676 | CA | ASN | A | 408 | 12266 | 7325 | 5801 | 72 | −645 | 759 | C |
| ATOM | 2677 | C | ASN | A | 408 | 11.697 | 95.429 | 67.225 | 1.00 | 67.22 | | C |
| ANISOU | 2677 | C | ASN | A | 408 | 12073 | 7460 | 6009 | 148 | −1034 | 733 | C |
| ATOM | 2678 | O | ASN | A | 408 | 12.488 | 95.998 | 67.974 | 1.00 | 74.83 | | O |
| ANISOU | 2678 | O | ASN | A | 408 | 13162 | 8359 | 6912 | 186 | −1281 | 693 | O |
| ATOM | 2679 | CB | ASN | A | 408 | 10.357 | 94.827 | 69.246 | 1.00 | 65.46 | | C |
| ANISOU | 2679 | CB | ASN | A | 408 | 12546 | 6952 | 5373 | 76 | −662 | 758 | C |
| ATOM | 2680 | CG | ASN | A | 408 | 9.010 | 94.409 | 69.791 | 1.00 | 73.08 | | C |
| ANISOU | 2680 | CG | ASN | A | 408 | 13753 | 7811 | 6204 | −4 | −241 | 771 | C |
| ATOM | 2681 | OD1 | ASN | A | 408 | 8.877 | 93.349 | 70.405 | 1.00 | 79.86 | | O |
| ANISOU | 2681 | OD1 | ASN | A | 408 | 14878 | 8517 | 6950 | −4 | −182 | 828 | O |
| ATOM | 2682 | ND2 | ASN | A | 408 | 7.993 | 95.239 | 69.557 | 1.00 | 72.80 | | N |
| ANISOU | 2682 | ND2 | ASN | A | 408 | 13614 | 7843 | 6203 | −73 | 65 | 713 | N |
| ATOM | 2683 | N | TYR | A | 409 | 11.954 | 95.191 | 65.943 | 1.00 | 60.35 | | N |
| ANISOU | 2683 | N | TYR | A | 409 | 10853 | 6718 | 5357 | 166 | −1077 | 751 | N |
| ATOM | 2684 | CA | TYR | A | 409 | 13.086 | 95.818 | 65.290 | 1.00 | 57.59 | | C |
| ANISOU | 2684 | CA | TYR | A | 409 | 10211 | 6464 | 5206 | 221 | −1367 | 710 | C |
| ATOM | 2685 | C | TYR | A | 409 | 12.695 | 97.157 | 64.656 | 1.00 | 52.71 | | C |
| ANISOU | 2685 | C | TYR | A | 409 | 9386 | 5997 | 4643 | 175 | −1262 | 642 | C |
| ATOM | 2686 | O | TYR | A | 409 | 11.779 | 97.234 | 63.831 | 1.00 | 54.10 | | O |
| ANISOU | 2686 | O | TYR | A | 409 | 9431 | 6271 | 4853 | 124 | −1017 | 647 | O |
| ATOM | 2687 | CB | TYR | A | 409 | 13.688 | 94.908 | 64.220 | 1.00 | 55.15 | | C |
| ANISOU | 2687 | CB | TYR | A | 409 | 9638 | 6196 | 5121 | 275 | −1481 | 754 | C |
| ATOM | 2688 | CG | TYR | A | 409 | 14.860 | 95.572 | 63.523 | 1.00 | 56.70 | | C |
| ANISOU | 2688 | CG | TYR | A | 409 | 9507 | 6474 | 5561 | 326 | −1740 | 699 | C |
| ATOM | 2689 | CD2 | TYR | A | 409 | 14.680 | 96.272 | 62.342 | 1.00 | 53.47 | | C |
| ANISOU | 2689 | CD2 | TYR | A | 409 | 8801 | 6222 | 5294 | 301 | −1654 | 667 | C |
| ATOM | 2690 | CD1 | TYR | A | 409 | 16.140 | 95.534 | 64.073 | 1.00 | 57.62 | | C |
| ANISOU | 2690 | CD1 | TYR | A | 409 | 9620 | 6493 | 5779 | 393 | −2064 | 673 | C |
| ATOM | 2691 | CE2 | TYR | A | 409 | 15.736 | 96.888 | 61.714 | 1.00 | 56.48 | | C |
| ANISOU | 2691 | CE2 | TYR | A | 409 | 8884 | 6661 | 5916 | 337 | −1852 | 613 | C |
| ATOM | 2692 | CE1 | TYR | A | 409 | 17.208 | 96.153 | 63.449 | 1.00 | 54.03 | | C |
| ANISOU | 2692 | CE1 | TYR | A | 409 | 8844 | 6092 | 5593 | 428 | −2263 | 613 | C |
| ATOM | 2693 | CZ | TYR | A | 409 | 16.997 | 96.829 | 62.265 | 1.00 | 58.20 | | C |
| ANISOU | 2693 | CZ | TYR | A | 409 | 9074 | 6778 | 6261 | 398 | −2140 | 585 | C |
| ATOM | 2694 | OH | TYR | A | 409 | 18.041 | 97.453 | 61.614 | 1.00 | 63.64 | | O |
| ANISOU | 2694 | OH | TYR | A | 409 | 9438 | 7507 | 7234 | 423 | −2297 | 523 | O |
| ATOM | 2695 | N | LYS | A | 410 | 13.426 | 98.197 | 65.026 | 1.00 | 42.56 | | N |
| ANISOU | 2695 | N | LYS | A | 410 | 8073 | 4717 | 3383 | 193 | −1463 | 577 | N |
| ATOM | 2696 | CA | LYS | A | 410 | 13.194 | 99.524 | 64.500 | 1.00 | 46.89 | | C |
| ANISOU | 2696 | CA | LYS | A | 410 | 8439 | 5390 | 3989 | 155 | −1402 | 511 | C |
| ATOM | 2697 | C | LYS | A | 410 | 13.988 | 99.693 | 63.196 | 1.00 | 45.37 | | C |
| ANISOU | 2697 | C | LYS | A | 410 | 7852 | 5316 | 4069 | 184 | −1547 | 499 | C |
| ATOM | 2698 | O | LYS | A | 410 | 15.208 | 99.878 | 63.211 | 1.00 | 50.12 | | O |
| ANISOU | 2698 | O | LYS | A | 410 | 8321 | 5889 | 4833 | 232 | −1817 | 471 | O |
| ATOM | 2699 | CB | LYS | A | 410 | 13.558 | 100.566 | 65.562 | 1.00 | 50.48 | | C |
| ANISOU | 2699 | CB | LYS | A | 410 | 9075 | 5768 | 4337 | 155 | −1534 | 445 | C |
| ATOM | 2700 | CG | LYS | A | 410 | 12.676 | 101.813 | 65.553 | 1.00 | 53.73 | | C |
| ANISOU | 2700 | CG | LYS | A | 410 | 9497 | 6248 | 4669 | 94 | −1329 | 384 | C |
| ATOM | 2701 | CD | LYS | A | 410 | 13.112 | 102.863 | 66.595 | 1.00 | 53.71 | | C |
| ANISOU | 2701 | CD | LYS | A | 410 | 9682 | 6156 | 4568 | 99 | −1481 | 316 | C |
| ATOM | 2702 | CE | LYS | A | 410 | 14.459 | 103.510 | 66.279 | 1.00 | 57.38 | | C |
| ANISOU | 2702 | CE | LYS | A | 410 | 9914 | 6643 | 5245 | 136 | −1812 | 273 | C |
| ATOM | 2703 | NZ | LYS | A | 410 | 15.511 | 103.004 | 67.228 | 1.00 | 61.78 | | N |
| ANISOU | 2703 | NZ | LYS | A | 410 | 10651 | 7035 | 5787 | 194 | −2112 | 279 | N |
| ATOM | 2704 | N | MET | A | 411 | 13.284 | 99.605 | 62.069 | 1.00 | 35.80 | | N |
| ANISOU | 2704 | N | MET | A | 411 | 6461 | 4220 | 2920 | 152 | −1357 | 515 | N |
| ATOM | 2705 | CA | MET | A | 411 | 13.905 | 99.643 | 60.747 | 1.00 | 29.69 | | C |
| ANISOU | 2705 | CA | MET | A | 411 | 5344 | 3546 | 2390 | 176 | −1451 | 509 | C |
| ATOM | 2706 | C | MET | A | 411 | 13.891 | 101.038 | 60.130 | 1.00 | 32.93 | | C |
| ANISOU | 2706 | C | MET | A | 411 | 5548 | 4067 | 2898 | 135 | −1422 | 438 | C |
| ATOM | 2707 | O | MET | A | 411 | 12.893 | 101.735 | 60.186 | 1.00 | 35.16 | | O |
| ANISOU | 2707 | O | MET | A | 411 | 5886 | 4395 | 3080 | 78 | −1218 | 405 | O |
| ATOM | 2708 | CB | MET | A | 411 | 13.199 | 98.671 | 59.820 | 1.00 | 28.65 | | C |
| ANISOU | 2708 | CB | MET | A | 411 | 5088 | 3461 | 2335 | 159 | −1225 | 541 | C |
| ATOM | 2709 | CG | MET | A | 411 | 13.623 | 98.800 | 58.375 | 1.00 | 37.46 | | C |
| ANISOU | 2709 | CG | MET | A | 411 | 5816 | 4687 | 3729 | 164 | −1191 | 499 | C |
| ATOM | 2710 | SD | MET | A | 411 | 12.777 | 97.569 | 57.376 | 1.00 | 61.52 | | S |
| ANISOU | 2710 | SD | MET | A | 411 | 8757 | 7762 | 6854 | 146 | −945 | 516 | S |
| ATOM | 2711 | CE | MET | A | 411 | 13.423 | 96.119 | 58.144 | 1.00 | 58.18 | | C |
| ANISOU | 2711 | CE | MET | A | 411 | 8525 | 7189 | 6391 | 219 | −1112 | 597 | C |
| ATOM | 2712 | N | LYS | A | 412 | 15.007 | 101.426 | 59.526 | 1.00 | 37.30 | | N |
| ANISOU | 2712 | N | LYS | A | 412 | 5835 | 4648 | 3689 | 163 | −1598 | 405 | N |
| ATOM | 2713 | CA | LYS | A | 412 | 15.180 | 102.757 | 58.956 | 1.00 | 35.10 | | C |
| ANISOU | 2713 | CA | LYS | A | 412 | 5351 | 4448 | 3537 | 122 | −1575 | 340 | C |
| ATOM | 2714 | C | LYS | A | 412 | 14.553 | 102.869 | 57.575 | 1.00 | 30.21 | | C |
| ANISOU | 2714 | C | LYS | A | 412 | 4490 | 3947 | 3041 | 82 | −1311 | 327 | C |
| ATOM | 2715 | O | LYS | A | 412 | 14.844 | 102.078 | 56.688 | 1.00 | 34.00 | | O |
| ANISOU | 2715 | O | LYS | A | 412 | 4801 | 4451 | 3667 | 104 | −1258 | 344 | O |
| ATOM | 2716 | CB | LYS | A | 412 | 16.673 | 103.108 | 58.896 | 1.00 | 35.88 | | C |
| ANISOU | 2716 | CB | LYS | A | 412 | 5261 | 4498 | 3872 | 159 | −1855 | 309 | C |
| ATOM | 2717 | CG | LYS | A | 412 | 17.005 | 104.403 | 58.173 | 1.00 | 42.09 | | C |
| ANISOU | 2717 | CG | LYS | A | 412 | 5803 | 5347 | 4840 | 111 | −1814 | 249 | C |
| ATOM | 2718 | CD | LYS | A | 412 | 18.526 | 104.619 | 58.094 | 1.00 | 45.68 | | C |
| ANISOU | 2718 | CD | LYS | A | 412 | 6031 | 5727 | 5598 | 140 | −2062 | 212 | C |
| ATOM | 2719 | CE | LYS | A | 412 | 19.132 | 104.894 | 59.458 | 1.00 | 44.98 | | C |
| ANISOU | 2719 | CE | LYS | A | 412 | 6117 | 5513 | 5458 | 162 | −2264 | 174 | C |
| ATOM | 2720 | NZ | LYS | A | 412 | 20.625 | 104.924 | 59.435 | 1.00 | 44.73 | | N |
| ANISOU | 2720 | NZ | LYS | A | 412 | 5854 | 5378 | 5761 | 192 | −2464 | 128 | N |
| ATOM | 2721 | N | TRP | A | 413 | 13.668 | 103.845 | 57.403 | 1.00 | 29.45 | | N |
| ANISOU | 2721 | N | TRP | A | 413 | 4401 | 3911 | 2879 | 28 | −1156 | 293 | N |
| ATOM | 2722 | CA | TRP | A | 413 | 13.041 | 104.087 | 56.110 | 1.00 | 24.46 | | C |
| ANISOU | 2722 | CA | TRP | A | 413 | 3575 | 3371 | 2348 | −4 | −955 | 278 | C |
| ATOM | 2723 | C | TRP | A | 413 | 13.542 | 105.418 | 55.594 | 1.00 | 31.17 | | C |
| ANISOU | 2723 | C | TRP | A | 413 | 4271 | 4253 | 3317 | −31 | −992 | 239 | C |
| ATOM | 2724 | O | TRP | A | 413 | 13.120 | 106.485 | 56.067 | 1.00 | 31.38 | | O |
| ANISOU | 2724 | O | TRP | A | 413 | 4376 | 4276 | 3270 | −60 | −987 | 205 | O |
| ATOM | 2725 | CB | TRP | A | 413 | 11.521 | 104.092 | 56.235 | 1.00 | 20.30 | | C |
| ANISOU | 2725 | CB | TRP | A | 413 | 3156 | 2860 | 1696 | −39 | −749 | 269 | C |
| ATOM | 2726 | CG | TRP | A | 413 | 10.771 | 104.037 | 54.931 | 1.00 | 21.84 | | C |
| ANISOU | 2726 | CG | TRP | A | 413 | 3182 | 3123 | 1992 | −59 | −592 | 257 | C |
| ATOM | 2727 | CD1 | TRP | A | 413 | 11.277 | 103.759 | 53.700 | 1.00 | 26.58 | | C |
| ANISOU | 2727 | CD1 | TRP | A | 413 | 3610 | 3766 | 2722 | −47 | −589 | 263 | C |
| ATOM | 2728 | CD2 | TRP | A | 413 | 9.364 | 104.242 | 54.749 | 1.00 | 21.50 | | C |
| ANISOU | 2728 | CD2 | TRP | A | 413 | 3148 | 3091 | 1932 | −90 | −425 | 228 | C |
| ATOM | 2729 | NE1 | TRP | A | 413 | 10.279 | 103.796 | 52.760 | 1.00 | 22.37 | | N |
| ANISOU | 2729 | NE1 | TRP | A | 413 | 3013 | 3270 | 2218 | −67 | −464 | 244 | N |
| ATOM | 2730 | CE2 | TRP | A | 413 | 9.091 | 104.077 | 53.382 | 1.00 | 19.01 | | C |
| ANISOU | 2730 | CE2 | TRP | A | 413 | 2671 | 2823 | 1728 | −91 | −378 | 221 | C |
| ATOM | 2731 | CE3 | TRP | A | 413 | 8.303 | 104.543 | 55.622 | 1.00 | 27.42 | | C |
| ANISOU | 2731 | CE3 | TRP | A | 413 | 4027 | 3796 | 2597 | −116 | −305 | 201 | C |
| ATOM | 2732 | CZ2 | TRP | A | 413 | 7.801 | 104.200 | 52.852 | 1.00 | 27.76 | | C |
| ANISOU | 2732 | CZ2 | TRP | A | 413 | 3728 | 3933 | 2885 | −111 | −269 | 186 | C |
| ATOM | 2733 | CZ3 | TRP | A | 413 | 7.023 | 104.671 | 55.098 | 1.00 | 24.04 | | C |
| ANISOU | 2733 | CZ3 | TRP | A | 413 | 3510 | 3370 | 2255 | −140 | −156 | 162 | C |
| ATOM | 2734 | CH2 | TRP | A | 413 | 6.783 | 104.500 | 53.724 | 1.00 | 23.51 | | C |
| ANISOU | 2734 | CH2 | TRP | A | 413 | 3265 | 3349 | 2318 | −135 | −165 | 154 | C |
| ATOM | 2735 | N | GLN | A | 414 | 14.451 | 105.349 | 54.631 | 1.00 | 27.03 | | N |
| ANISOU | 2735 | N | GLN | A | 414 | 3539 | 3746 | 2986 | −22 | −1007 | 241 | N |
| ATOM | 2736 | CA | GLN | A | 414 | 15.156 | 106.523 | 54.155 | 1.00 | 24.44 | | C |
| ANISOU | 2736 | CA | GLN | A | 414 | 3062 | 3421 | 2804 | −53 | −1037 | 212 | C |
| ATOM | 2737 | C | GLN | A | 414 | 14.405 | 107.322 | 53.089 | 1.00 | 25.17 | | C |
| ANISOU | 2737 | C | GLN | A | 414 | 3098 | 3572 | 2892 | −94 | −858 | 208 | C |
| ATOM | 2738 | O | GLN | A | 414 | 13.626 | 106.767 | 52.322 | 1.00 | 29.67 | | O |
| ANISOU | 2738 | O | GLN | A | 414 | 3673 | 4186 | 3415 | −91 | −723 | 224 | O |
| ATOM | 2739 | CB | GLN | A | 414 | 16.514 | 106.109 | 53.601 | 1.00 | 30.39 | | C |
| ANISOU | 2739 | CB | GLN | A | 414 | 3614 | 4136 | 3796 | −32 | −1094 | 212 | C |
| ATOM | 2740 | CG | GLN | A | 414 | 17.485 | 105.579 | 54.617 | 1.00 | 30.91 | | C |
| ANISOU | 2740 | CG | GLN | A | 414 | 3692 | 4112 | 3939 | 16 | −1342 | 206 | C |
| ATOM | 2741 | CD | GLN | A | 414 | 18.782 | 105.210 | 53.952 | 1.00 | 38.58 | | C |
| ANISOU | 2741 | CD | GLN | A | 414 | 4408 | 5032 | 5217 | 39 | −1366 | 191 | C |
| ATOM | 2742 | OE1 | GLN | A | 414 | 19.483 | 106.077 | 53.429 | 1.00 | 47.01 | | O |
| ANISOU | 2742 | OE1 | GLN | A | 414 | 5294 | 6079 | 6490 | −1 | −1332 | 160 | O |
| ATOM | 2743 | NE2 | GLN | A | 414 | 19.102 | 103.914 | 53.937 | 1.00 | 36.10 | | N |
| ANISOU | 2743 | NE2 | GLN | A | 414 | 4072 | 4683 | 4960 | 100 | −1399 | 211 | N |
| ATOM | 2744 | N | PRO | A | 415 | 14.684 | 108.631 | 53.012 | 1.00 | 25.60 | | N |
| ANISOU | 2744 | N | PRO | A | 415 | 3103 | 3613 | 3010 | −132 | −881 | 184 | N |
| ATOM | 2745 | CA | PRO | A | 415 | 14.069 | 109.478 | 51.988 | 1.00 | 22.98 | | C |
| ANISOU | 2745 | CA | PRO | A | 415 | 2739 | 3313 | 2679 | −165 | −742 | 189 | C |
| ATOM | 2746 | C | PRO | A | 415 | 14.333 | 108.994 | 50.564 | 1.00 | 24.19 | | C |
| ANISOU | 2746 | C | PRO | A | 415 | 2800 | 3487 | 2905 | −165 | −607 | 219 | C |
| ATOM | 2747 | O | PRO | A | 415 | 13.457 | 109.186 | 49.716 | 1.00 | 22.93 | | O |
| ANISOU | 2747 | O | PRO | A | 415 | 2687 | 3354 | 2671 | −171 | −508 | 231 | O |
| ATOM | 2748 | CB | PRO | A | 415 | 14.719 | 110.850 | 52.233 | 1.00 | 19.55 | | C |
| ANISOU | 2748 | CB | PRO | A | 415 | 2255 | 2830 | 2345 | −206 | −815 | 163 | C |
| ATOM | 2749 | CG | PRO | A | 415 | 15.127 | 110.818 | 53.663 | 1.00 | 25.62 | | C |
| ANISOU | 2749 | CG | PRO | A | 415 | 3101 | 3552 | 3083 | −192 | −1004 | 128 | C |
| ATOM | 2750 | CD | PRO | A | 415 | 15.548 | 109.403 | 53.922 | 1.00 | 20.82 | | C |
| ANISOU | 2750 | CD | PRO | A | 415 | 2492 | 2942 | 2477 | −145 | −1063 | 149 | C |
| ATOM | 2751 | N | HIS | A | 416 | 15.470 | 108.344 | 50.288 | 1.00 | 27.81 | | N |
| ANISOU | 2751 | N | HIS | A | 416 | 3144 | 3918 | 3506 | −153 | −607 | 223 | N |
| ATOM | 2752 | CA | HIS | A | 416 | 15.664 | 107.847 | 48.924 | 1.00 | 23.44 | | C |
| ANISOU | 2752 | CA | HIS | A | 416 | 2543 | 3370 | 2991 | −153 | −439 | 241 | C |
| ATOM | 2753 | C | HIS | A | 416 | 14.726 | 106.669 | 48.630 | 1.00 | 28.90 | | C |
| ANISOU | 2753 | C | HIS | A | 416 | 3328 | 4106 | 3545 | −115 | −395 | 249 | C |
| ATOM | 2754 | O | HIS | A | 416 | 14.689 | 106.183 | 47.496 | 1.00 | 23.82 | | O |
| ANISOU | 2754 | O | HIS | A | 416 | 2698 | 3466 | 2888 | −110 | −270 | 255 | O |
| ATOM | 2755 | CB | HIS | A | 416 | 17.120 | 107.444 | 48.611 | 1.00 | 23.83 | | C |
| ANISOU | 2755 | CB | HIS | A | 416 | 2424 | 3360 | 3270 | −149 | −399 | 230 | C |
| ATOM | 2756 | CG | HIS | A | 416 | 17.636 | 106.252 | 49.365 | 1.00 | 30.37 | | C |
| ANISOU | 2756 | CG | HIS | A | 416 | 3198 | 4166 | 4175 | −93 | −521 | 218 | C |
| ATOM | 2757 | ND1 | HIS | A | 416 | 18.940 | 106.170 | 49.806 | 1.00 | 27.89 | | N |
| ANISOU | 2757 | ND1 | HIS | A | 416 | 2710 | 3772 | 4113 | −79 | −623 | 191 | N |
| ATOM | 2758 | CD2 | HIS | A | 416 | 17.030 | 105.110 | 49.769 | 1.00 | 28.39 | | C |
| ANISOU | 2758 | CD2 | HIS | A | 416 | 3043 | 3942 | 3800 | −45 | −570 | 229 | C |
| ATOM | 2759 | CE1 | HIS | A | 416 | 19.118 | 105.024 | 50.437 | 1.00 | 27.56 | | C |
| ANISOU | 2759 | CE1 | HIS | A | 416 | 2676 | 3710 | 4085 | −16 | −749 | 191 | C |
| ATOM | 2760 | NE2 | HIS | A | 416 | 17.974 | 104.364 | 50.431 | 1.00 | 24.15 | | N |
| ANISOU | 2760 | NE2 | HIS | A | 416 | 2418 | 3343 | 3416 | 2 | −706 | 219 | N |
| ATOM | 2761 | N | SER | A | 417 | 13.975 | 106.213 | 49.636 | 1.00 | 17.96 | | N |
| ANISOU | 2761 | N | SER | A | 417 | 2025 | 2739 | 2059 | −94 | −486 | 245 | N |
| ATOM | 2762 | CA | SER | A | 417 | 12.912 | 105.240 | 49.380 | 1.00 | 20.29 | | C |
| ANISOU | 2762 | CA | SER | A | 417 | 2400 | 3061 | 2249 | −74 | −434 | 247 | C |
| ATOM | 2763 | C | SER | A | 417 | 11.540 | 105.899 | 49.335 | 1.00 | 21.46 | | C |
| ANISOU | 2763 | C | SER | A | 417 | 2622 | 3229 | 2303 | −93 | −414 | 234 | C |
| ATOM | 2764 | O | SER | A | 417 | 10.835 | 105.799 | 48.334 | 1.00 | 22.12 | | O |
| ANISOU | 2764 | O | SER | A | 417 | 2726 | 3322 | 2357 | −93 | −360 | 228 | O |
| ATOM | 2765 | CB | SER | A | 417 | 12.910 | 104.124 | 50.433 | 1.00 | 21.77 | | C |
| ANISOU | 2765 | CB | SER | A | 417 | 2636 | 3228 | 2409 | −42 | −504 | 255 | C |
| ATOM | 2766 | OG | SER | A | 417 | 14.105 | 103.367 | 50.349 | 1.00 | 30.32 | | O |
| ANISOU | 2766 | OG | SER | A | 417 | 3634 | 4276 | 3611 | −9 | −538 | 262 | O |
| ATOM | 2767 | N | TYR | A | 418 | 11.159 | 106.575 | 50.416 | 1.00 | 17.74 | | N |
| ANISOU | 2767 | N | TYR | A | 418 | 2196 | 2749 | 1794 | −105 | −466 | 221 | N |
| ATOM | 2768 | CA | TYR | A | 418 | 9.794 | 107.070 | 50.505 | 1.00 | 19.92 | | C |
| ANISOU | 2768 | CA | TYR | A | 418 | 2519 | 3026 | 2025 | −116 | −430 | 196 | C |
| ATOM | 2769 | C | TYR | A | 418 | 9.573 | 108.308 | 49.625 | 1.00 | 23.56 | | C |
| ANISOU | 2769 | C | TYR | A | 418 | 2954 | 3483 | 2516 | −130 | −427 | 193 | C |
| ATOM | 2770 | O | TYR | A | 418 | 8.436 | 108.688 | 49.376 | 1.00 | 26.06 | | O |
| ANISOU | 2770 | O | TYR | A | 418 | 3281 | 3786 | 2836 | −127 | −416 | 169 | O |
| ATOM | 2771 | CB | TYR | A | 418 | 9.401 | 107.353 | 51.964 | 1.00 | 27.18 | | C |
| ANISOU | 2771 | CB | TYR | A | 418 | 3526 | 3918 | 2885 | −122 | −443 | 173 | C |
| ATOM | 2772 | CG | TYR | A | 418 | 10.083 | 108.511 | 52.701 | 1.00 | 29.53 | | C |
| ANISOU | 2772 | CG | TYR | A | 418 | 3852 | 4195 | 3175 | −137 | −524 | 160 | C |
| ATOM | 2773 | CD1 | TYR | A | 418 | 9.744 | 109.831 | 52.432 | 1.00 | 24.16 | | C |
| ANISOU | 2773 | CD1 | TYR | A | 418 | 3147 | 3504 | 2529 | −154 | −518 | 136 | C |
| ATOM | 2774 | CD2 | TYR | A | 418 | 10.992 | 108.271 | 53.732 | 1.00 | 23.96 | | C |
| ANISOU | 2774 | CD2 | TYR | A | 418 | 3213 | 3459 | 2430 | −129 | −629 | 164 | C |
| ATOM | 2775 | CE1 | TYR | A | 418 | 10.315 | 110.868 | 53.122 | 1.00 | 23.52 | | C |
| ANISOU | 2775 | CE1 | TYR | A | 418 | 3096 | 3390 | 2449 | −171 | −593 | 113 | C |
| ATOM | 2776 | CE2 | TYR | A | 418 | 11.577 | 109.313 | 54.429 | 1.00 | 28.36 | | C |
| ANISOU | 2776 | CE2 | TYR | A | 418 | 3807 | 3981 | 2988 | −144 | −733 | 137 | C |
| ATOM | 2777 | CZ | TYR | A | 418 | 11.233 | 110.614 | 54.117 | 1.00 | 30.01 | | C |
| ANISOU | 2777 | CZ | TYR | A | 418 | 3980 | 4186 | 3235 | −169 | −704 | 109 | C |
| ATOM | 2778 | OH | TYR | A | 418 | 11.805 | 111.666 | 54.798 | 1.00 | 28.42 | | O |
| ANISOU | 2778 | OH | TYR | A | 418 | 3815 | 3937 | 3045 | −188 | −810 | 73 | O |
| ATOM | 2779 | N | LEU | A | 419 | 10.643 | 108.915 | 49.126 | 1.00 | 20.09 | | N |
| ANISOU | 2779 | N | LEU | A | 419 | 2477 | 3038 | 2120 | −145 | −436 | 216 | N |
| ATOM | 2780 | CA | LEU | A | 419 | 10.483 | 109.932 | 48.095 | 1.00 | 18.88 | | C |
| ANISOU | 2780 | CA | LEU | A | 419 | 2337 | 2862 | 1974 | −160 | −414 | 231 | C |
| ATOM | 2781 | C | LEU | A | 419 | 10.802 | 109.304 | 46.765 | 1.00 | 26.37 | | C |
| ANISOU | 2781 | C | LEU | A | 419 | 3309 | 3810 | 2900 | −153 | −347 | 257 | C |
| ATOM | 2782 | O | LEU | A | 419 | 11.681 | 108.448 | 46.690 | 1.00 | 26.25 | | O |
| ANISOU | 2782 | O | LEU | A | 419 | 3252 | 3804 | 2918 | −149 | −301 | 264 | O |
| ATOM | 2783 | CB | LEU | A | 419 | 11.384 | 111.137 | 48.332 | 1.00 | 17.18 | | C |
| ANISOU | 2783 | CB | LEU | A | 419 | 2088 | 2614 | 1824 | −195 | −431 | 240 | C |
| ATOM | 2784 | CG | LEU | A | 419 | 11.276 | 111.839 | 49.691 | 1.00 | 26.45 | | C |
| ANISOU | 2784 | CG | LEU | A | 419 | 3267 | 3773 | 3008 | −204 | −509 | 202 | C |
| ATOM | 2785 | CD1 | LEU | A | 419 | 12.293 | 112.951 | 49.794 | 1.00 | 22.77 | | C |
| ANISOU | 2785 | CD1 | LEU | A | 419 | 2755 | 3260 | 2637 | −245 | −540 | 205 | C |
| ATOM | 2786 | CD2 | LEU | A | 419 | 9.862 | 112.368 | 49.934 | 1.00 | 25.68 | | C |
| ANISOU | 2786 | CD2 | LEU | A | 419 | 3225 | 3664 | 2867 | −188 | −510 | 170 | C |
| ATOM | 2787 | N | TYR | A | 420 | 10.083 | 109.721 | 45.723 | 1.00 | 20.78 | | N |
| ANISOU | 2787 | N | TYR | A | 420 | 2686 | 3075 | 2134 | −147 | −350 | 268 | N |
| ATOM | 2788 | CA | TYR | A | 420 | 10.393 | 109.298 | 44.372 | 1.00 | 20.49 | | C |
| ANISOU | 2788 | CA | TYR | A | 420 | 2740 | 3015 | 2030 | −143 | −282 | 291 | C |
| ATOM | 2789 | C | TYR | A | 420 | 10.711 | 110.478 | 43.432 | 1.00 | 24.88 | | C |
| ANISOU | 2789 | C | TYR | A | 420 | 3402 | 3506 | 2543 | −168 | −238 | 337 | C |
| ATOM | 2790 | O | TYR | A | 420 | 10.316 | 111.610 | 43.675 | 1.00 | 26.37 | | O |
| ANISOU | 2790 | O | TYR | A | 420 | 3601 | 3666 | 2752 | −177 | −301 | 347 | O |
| ATOM | 2791 | CB | TYR | A | 420 | 9.248 | 108.497 | 43.805 | 1.00 | 21.67 | | C |
| ANISOU | 2791 | CB | TYR | A | 420 | 2961 | 3161 | 2112 | −107 | −350 | 262 | C |
| ATOM | 2792 | CG | TYR | A | 420 | 7.967 | 109.268 | 43.570 | 1.00 | 24.83 | | C |
| ANISOU | 2792 | CG | TYR | A | 420 | 3409 | 3519 | 2506 | −88 | −477 | 249 | C |
| ATOM | 2793 | CD1 | TYR | A | 420 | 7.057 | 109.482 | 44.597 | 1.00 | 26.78 | | C |
| ANISOU | 2793 | CD1 | TYR | A | 420 | 3552 | 3775 | 2848 | −80 | −539 | 208 | C |
| ATOM | 2794 | CD2 | TYR | A | 420 | 7.645 | 109.731 | 42.315 | 1.00 | 19.95 | | C |
| ANISOU | 2794 | CD2 | TYR | A | 420 | 2953 | 2835 | 1794 | −74 | −535 | 271 | C |
| ATOM | 2795 | CE1 | TYR | A | 420 | 5.879 | 110.161 | 44.373 | 1.00 | 24.58 | | C |
| ANISOU | 2795 | CE1 | TYR | A | 420 | 3280 | 3439 | 2621 | −55 | −653 | 183 | C |
| ATOM | 2796 | CE2 | TYR | A | 420 | 6.476 | 110.396 | 42.084 | 1.00 | 21.93 | | C |
| ANISOU | 2796 | CE2 | TYR | A | 420 | 3236 | 3026 | 2070 | −43 | −692 | 255 | C |
| ATOM | 2797 | CZ | TYR | A | 420 | 5.596 | 110.616 | 43.114 | 1.00 | 23.34 | | C |
| ANISOU | 2797 | CZ | TYR | A | 420 | 3260 | 3214 | 2395 | −32 | −751 | 206 | C |
| ATOM | 2798 | OH | TYR | A | 420 | 4.419 | 111.277 | 42.868 | 1.00 | 23.58 | | O |
| ANISOU | 2798 | OH | TYR | A | 420 | 3286 | 3166 | 2506 | 6 | −908 | 177 | O |
| ATOM | 2799 | N | LYS | A | 421 | 11.435 | 110.187 | 42.359 | 1.00 | 29.02 | | N |
| ANISOU | 2799 | N | LYS | A | 421 | 4025 | 3993 | 3008 | −180 | −109 | 363 | N |
| ATOM | 2800 | CA | LYS | A | 421 | 11.818 | 111.181 | 41.379 | 1.00 | 24.21 | | C |
| ANISOU | 2800 | CA | LYS | A | 421 | 3565 | 3300 | 2332 | −212 | −19 | 418 | C |
| ATOM | 2801 | C | LYS | A | 421 | 10.644 | 111.577 | 40.485 | 1.00 | 27.63 | | C |
| ANISOU | 2801 | C | LYS | A | 421 | 4214 | 3677 | 2606 | −178 | −148 | 436 | C |
| ATOM | 2802 | O | LYS | A | 421 | 10.056 | 110.736 | 39.808 | 1.00 | 28.69 | | O |
| ANISOU | 2802 | O | LYS | A | 421 | 4467 | 3805 | 2628 | −141 | −205 | 412 | O |
| ATOM | 2803 | CB | LYS | A | 421 | 12.968 | 110.652 | 40.524 | 1.00 | 26.04 | | C |
| ANISOU | 2803 | CB | LYS | A | 421 | 3855 | 3490 | 2548 | −238 | 207 | 432 | C |
| ATOM | 2804 | CG | LYS | A | 421 | 13.728 | 111.727 | 39.765 | 1.00 | 44.05 | | C |
| ANISOU | 2804 | CG | LYS | A | 421 | 6252 | 5668 | 4816 | −296 | 381 | 493 | C |
| ATOM | 2805 | CD | LYS | A | 421 | 14.410 | 112.685 | 40.743 | 1.00 | 57.12 | | C |
| ANISOU | 2805 | CD | LYS | A | 421 | 7699 | 7319 | 6685 | −345 | 385 | 498 | C |
| ATOM | 2806 | CE | LYS | A | 421 | 15.377 | 113.624 | 40.049 | 1.00 | 63.18 | | C |
| ANISOU | 2806 | CE | LYS | A | 421 | 8532 | 7967 | 7505 | −420 | 609 | 552 | C |
| ATOM | 2807 | NZ | LYS | A | 421 | 15.742 | 114.765 | 40.932 | 1.00 | 69.14 | | N |
| ANISOU | 2807 | NZ | LYS | A | 421 | 9124 | 8699 | 8449 | −468 | 551 | 555 | N |
| ATOM | 2808 | N | LYS | A | 422 | 10.299 | 112.859 | 40.497 | 1.00 | 26.05 | | N |
| ANISOU | 2808 | N | LYS | A | 422 | 4065 | 3422 | 2413 | −187 | −220 | 471 | N |
| ATOM | 2809 | CA | LYS | A | 422 | 9.338 | 113.402 | 39.547 | 1.00 | 27.22 | | C |
| ANISOU | 2809 | CA | LYS | A | 422 | 4440 | 3480 | 2423 | −150 | −362 | 500 | C |
| ATOM | 2810 | C | LYS | A | 422 | 9.950 | 114.654 | 38.965 | 1.00 | 33.16 | | C |
| ANISOU | 2810 | C | LYS | A | 422 | 5349 | 4127 | 3124 | −194 | −262 | 582 | C |
| ATOM | 2811 | O | LYS | A | 422 | 10.111 | 115.664 | 39.662 | 1.00 | 34.05 | | O |
| ANISOU | 2811 | O | LYS | A | 422 | 5349 | 4227 | 3363 | −221 | −269 | 595 | O |
| ATOM | 2812 | CB | LYS | A | 422 | 8.000 | 113.714 | 40.203 | 1.00 | 28.49 | | C |
| ANISOU | 2812 | CB | LYS | A | 422 | 4495 | 3649 | 2679 | −100 | −592 | 454 | C |
| ATOM | 2813 | CG | LYS | A | 422 | 7.032 | 114.480 | 39.284 | 1.00 | 31.30 | | C |
| ANISOU | 2813 | CG | LYS | A | 422 | 5060 | 3884 | 2949 | −52 | −787 | 484 | C |
| ATOM | 2814 | CD | LYS | A | 422 | 5.640 | 114.613 | 39.907 | 1.00 | 29.28 | | C |
| ANISOU | 2814 | CD | LYS | A | 422 | 4649 | 3621 | 2853 | 7 | −1008 | 414 | C |
| ATOM | 2815 | CE | LYS | A | 422 | 4.547 | 114.744 | 38.853 | 1.00 | 33.02 | | C |
| ANISOU | 2815 | CE | LYS | A | 422 | 5308 | 3974 | 3265 | 76 | −1266 | 413 | C |
| ATOM | 2816 | NZ | LYS | A | 422 | 3.349 | 113.941 | 39.254 | 1.00 | 41.42 | | N |
| ANISOU | 2816 | NZ | LYS | A | 422 | 6186 | 5056 | 4497 | 123 | −1429 | 311 | N |
| ATOM | 2817 | N | GLU | A | 423 | 10.300 | 114.568 | 37.689 | 1.00 | 37.91 | | N |
| ANISOU | 2817 | N | GLU | A | 423 | 6231 | 4639 | 3532 | −204 | −155 | 635 | N |
| ATOM | 2818 | CA | GLU | A | 423 | 11.075 | 115.597 | 37.035 | 1.00 | 44.39 | | C |
| ANISOU | 2818 | CA | GLU | A | 423 | 7235 | 5339 | 4290 | −263 | 21 | 722 | C |
| ATOM | 2819 | C | GLU | A | 423 | 12.345 | 115.807 | 37.860 | 1.00 | 46.23 | | C |
| ANISOU | 2819 | C | GLU | A | 423 | 7202 | 5614 | 4749 | −340 | 241 | 713 | C |
| ATOM | 2820 | O | GLU | A | 423 | 13.108 | 114.865 | 38.080 | 1.00 | 50.06 | | O |
| ANISOU | 2820 | O | GLU | A | 423 | 7542 | 6163 | 5315 | −357 | 389 | 670 | O |
| ATOM | 2821 | CB | GLU | A | 423 | 10.256 | 116.877 | 36.875 | 1.00 | 45.02 | | C |
| ANISOU | 2821 | CB | GLU | A | 423 | 7452 | 5319 | 4336 | −237 | −174 | 775 | C |
| ATOM | 2822 | CG | GLU | A | 423 | 9.090 | 116.737 | 35.877 | 1.00 | 57.79 | | C |
| ANISOU | 2822 | CG | GLU | A | 423 | 9369 | 6851 | 5738 | −156 | −422 | 788 | C |
| ATOM | 2823 | CD | GLU | A | 423 | 9.514 | 116.263 | 34.478 | 1.00 | 76.68 | | C |
| ANISOU | 2823 | CD | GLU | A | 423 | 12151 | 9146 | 7839 | −166 | −284 | 838 | C |
| ATOM | 2824 | OE1 | GLU | A | 423 | 10.676 | 116.502 | 34.074 | 1.00 | 84.90 | | O |
| ANISOU | 2824 | OE1 | GLU | A | 423 | 13300 | 10131 | 8828 | −244 | 37 | 895 | O |
| ATOM | 2825 | OE2 | GLU | A | 423 | 8.677 | 115.646 | 33.777 | 1.00 | 79.01 | | O |
| ANISOU | 2825 | OE2 | GLU | A | 423 | 12571 | 9417 | 8031 | −96 | −477 | 780 | O |
| ATOM | 2826 | N | SER | A | 424 | 12.557 | 117.016 | 38.350 | 1.00 | 38.94 | | N |
| ANISOU | 2826 | N | SER | A | 424 | 6202 | 4642 | 3951 | −380 | 236 | 745 | N |
| ATOM | 2827 | CA | SER | A | 424 | 13.776 | 117.308 | 39.090 | 1.00 | 46.04 | | C |
| ANISOU | 2827 | CA | SER | A | 424 | 6854 | 5552 | 5088 | −457 | 408 | 729 | C |
| ATOM | 2828 | C | SER | A | 424 | 13.553 | 117.374 | 40.598 | 1.00 | 43.70 | | C |
| ANISOU | 2828 | C | SER | A | 424 | 6263 | 5358 | 4981 | −440 | 230 | 654 | C |
| ATOM | 2829 | O | SER | A | 424 | 14.461 | 117.731 | 41.344 | 1.00 | 47.49 | | O |
| ANISOU | 2829 | O | SER | A | 424 | 6543 | 5835 | 5668 | −496 | 294 | 630 | O |
| ATOM | 2830 | CB | SER | A | 424 | 14.359 | 118.631 | 38.593 | 1.00 | 51.46 | | C |
| ANISOU | 2830 | CB | SER | A | 424 | 7665 | 6083 | 5802 | −534 | 560 | 810 | C |
| ATOM | 2831 | OG | SER | A | 424 | 13.314 | 119.579 | 38.423 | 1.00 | 52.07 | | O |
| ANISOU | 2831 | OG | SER | A | 424 | 7917 | 6097 | 5771 | −493 | 357 | 854 | O |
| ATOM | 2832 | N | PHE | A | 425 | 12.358 | 116.989 | 41.042 | 1.00 | 30.15 | | N |
| ANISOU | 2832 | N | PHE | A | 425 | 4532 | 3719 | 3202 | −365 | 11 | 611 | N |
| ATOM | 2833 | CA | PHE | A | 425 | 12.035 | 116.996 | 42.458 | 1.00 | 23.18 | | C |
| ANISOU | 2833 | CA | PHE | A | 425 | 3431 | 2920 | 2455 | −346 | −128 | 539 | C |
| ATOM | 2834 | C | PHE | A | 425 | 11.931 | 115.575 | 43.019 | 1.00 | 28.83 | | C |
| ANISOU | 2834 | C | PHE | A | 425 | 4025 | 3753 | 3176 | −310 | −158 | 478 | C |
| ATOM | 2835 | O | PHE | A | 425 | 11.916 | 114.592 | 42.277 | 1.00 | 30.10 | | O |
| ANISOU | 2835 | O | PHE | A | 425 | 4265 | 3933 | 3239 | −289 | −102 | 484 | O |
| ATOM | 2836 | CB | PHE | A | 425 | 10.720 | 117.741 | 42.701 | 1.00 | 28.96 | | C |
| ANISOU | 2836 | CB | PHE | A | 425 | 4214 | 3626 | 3162 | −295 | −318 | 526 | C |
| ATOM | 2837 | CG | PHE | A | 425 | 10.802 | 119.235 | 42.473 | 1.00 | 25.43 | | C |
| ANISOU | 2837 | CG | PHE | A | 425 | 3854 | 3059 | 2750 | −325 | −322 | 576 | C |
| ATOM | 2838 | CD2 | PHE | A | 425 | 11.041 | 120.102 | 43.539 | 1.00 | 26.15 | | C |
| ANISOU | 2838 | CD2 | PHE | A | 425 | 3807 | 3138 | 2993 | −355 | −354 | 536 | C |
| ATOM | 2839 | CD1 | PHE | A | 425 | 10.631 | 119.770 | 41.195 | 1.00 | 31.56 | | C |
| ANISOU | 2839 | CD1 | PHE | A | 425 | 4880 | 3717 | 3393 | −323 | −304 | 662 | C |
| ATOM | 2840 | CE2 | PHE | A | 425 | 11.121 | 121.500 | 43.341 | 1.00 | 35.56 | | C |
| ANISOU | 2840 | CE2 | PHE | A | 425 | 5076 | 4203 | 4233 | −386 | −358 | 579 | C |
| ATOM | 2841 | CE1 | PHE | A | 425 | 10.712 | 121.166 | 40.980 | 1.00 | 37.89 | | C |
| ANISOU | 2841 | CE1 | PHE | A | 425 | 5782 | 4387 | 4228 | −352 | −305 | 720 | C |
| ATOM | 2842 | CZ | PHE | A | 425 | 10.957 | 122.028 | 42.056 | 1.00 | 35.99 | | C |
| ANISOU | 2842 | CZ | PHE | A | 425 | 5369 | 4137 | 4169 | −385 | −328 | 676 | C |
| ATOM | 2843 | N | TRP | A | 426 | 11.847 | 115.491 | 44.341 | 1.00 | 28.60 | | N |
| ANISOU | 2843 | N | TRP | A | 426 | 3834 | 3785 | 3247 | −302 | −245 | 419 | N |
| ATOM | 2844 | CA | TRP | A | 426 | 11.655 | 114.249 | 45.059 | 1.00 | 19.11 | | C |
| ANISOU | 2844 | CA | TRP | A | 426 | 2540 | 2674 | 2046 | −268 | −286 | 368 | C |
| ATOM | 2845 | C | TRP | A | 426 | 10.363 | 114.325 | 45.832 | 1.00 | 23.97 | | C |
| ANISOU | 2845 | C | TRP | A | 426 | 3146 | 3317 | 2644 | −226 | −412 | 321 | C |
| ATOM | 2846 | O | TRP | A | 426 | 10.263 | 115.122 | 46.756 | 1.00 | 22.18 | | O |
| ANISOU | 2846 | O | TRP | A | 426 | 2875 | 3075 | 2478 | −236 | −462 | 291 | O |
| ATOM | 2847 | CB | TRP | A | 426 | 12.814 | 114.006 | 46.006 | 1.00 | 19.16 | | C |
| ANISOU | 2847 | CB | TRP | A | 426 | 2395 | 2702 | 2182 | −299 | −268 | 342 | C |
| ATOM | 2848 | CG | TRP | A | 426 | 14.070 | 113.714 | 45.292 | 1.00 | 21.60 | | C |
| ANISOU | 2848 | CG | TRP | A | 426 | 2660 | 2977 | 2572 | −336 | −121 | 369 | C |
| ATOM | 2849 | CD1 | TRP | A | 426 | 15.023 | 114.607 | 44.920 | 1.00 | 25.80 | | C |
| ANISOU | 2849 | CD1 | TRP | A | 426 | 3157 | 3424 | 3221 | −398 | −16 | 396 | C |
| ATOM | 2850 | CD2 | TRP | A | 426 | 14.526 | 112.428 | 44.858 | 1.00 | 22.43 | | C |
| ANISOU | 2850 | CD2 | TRP | A | 426 | 2739 | 3110 | 2674 | −315 | −33 | 365 | C |
| ATOM | 2851 | NE1 | TRP | A | 426 | 16.048 | 113.963 | 44.268 | 1.00 | 27.63 | | N |
| ANISOU | 2851 | NE1 | TRP | A | 426 | 3333 | 3626 | 3539 | −420 | 155 | 405 | N |
| ATOM | 2852 | CE2 | TRP | A | 426 | 15.772 | 112.623 | 44.225 | 1.00 | 27.83 | | C |
| ANISOU | 2852 | CE2 | TRP | A | 426 | 3364 | 3722 | 3488 | −364 | 142 | 384 | C |
| ATOM | 2853 | CE3 | TRP | A | 426 | 14.004 | 111.133 | 44.948 | 1.00 | 26.31 | | C |
| ANISOU | 2853 | CE3 | TRP | A | 426 | 3246 | 3666 | 3086 | −263 | −71 | 342 | C |
| ATOM | 2854 | CZ2 | TRP | A | 426 | 16.504 | 111.568 | 43.673 | 1.00 | 29.78 | | C |
| ANISOU | 2854 | CZ2 | TRP | A | 426 | 3567 | 3960 | 3788 | −355 | 286 | 374 | C |
| ATOM | 2855 | CZ3 | TRP | A | 426 | 14.729 | 110.085 | 44.402 | 1.00 | 29.02 | | C |
| ANISOU | 2855 | CZ3 | TRP | A | 426 | 3556 | 4004 | 3465 | −253 | 46 | 338 | C |
| ATOM | 2856 | CH2 | TRP | A | 426 | 15.967 | 110.313 | 43.767 | 1.00 | 31.85 | | C |
| ANISOU | 2856 | CH2 | TRP | A | 426 | 3855 | 4291 | 3954 | −295 | 226 | 350 | C |
| ATOM | 2857 | N | CYS | A | 427 | 9.374 | 113.512 | 45.468 | 1.00 | 23.69 | | N |
| ANISOU | 2857 | N | CYS | A | 427 | 3149 | 3305 | 2545 | −181 | −454 | 305 | N |
| ATOM | 2858 | CA | CYS | A | 427 | 8.033 | 113.672 | 46.021 | 1.00 | 17.76 | | C |
| ANISOU | 2858 | CA | CYS | A | 427 | 2373 | 2547 | 1827 | −144 | −543 | 254 | C |
| ATOM | 2859 | C | CYS | A | 427 | 7.626 | 112.545 | 46.981 | 1.00 | 23.04 | | C |
| ANISOU | 2859 | C | CYS | A | 427 | 2966 | 3276 | 2514 | −130 | −528 | 203 | C |
| ATOM | 2860 | O | CYS | A | 427 | 8.044 | 111.399 | 46.832 | 1.00 | 30.67 | | O |
| ANISOU | 2860 | O | CYS | A | 427 | 3926 | 4285 | 3443 | −131 | −488 | 212 | O |
| ATOM | 2861 | CB | CYS | A | 427 | 7.022 | 113.777 | 44.889 | 1.00 | 18.32 | | C |
| ANISOU | 2861 | CB | CYS | A | 427 | 2534 | 2562 | 1867 | −103 | −633 | 264 | C |
| ATOM | 2862 | SG | CYS | A | 427 | 7.318 | 115.135 | 43.750 | 1.00 | 34.50 | | S |
| ANISOU | 2862 | SG | CYS | A | 427 | 4743 | 4507 | 3859 | −112 | −663 | 339 | S |
| ATOM | 2863 | N | LYS | A | 428 | 6.803 | 112.883 | 47.967 | 1.00 | 24.11 | | N |
| ANISOU | 2863 | N | LYS | A | 428 | 3059 | 3396 | 2707 | −120 | −540 | 149 | N |
| ATOM | 2864 | CA | LYS | A | 428 | 6.453 | 111.959 | 49.040 | 1.00 | 28.82 | | C |
| ANISOU | 2864 | CA | LYS | A | 428 | 3623 | 4023 | 3304 | −118 | −486 | 107 | C |
| ATOM | 2865 | C | LYS | A | 428 | 5.587 | 110.800 | 48.517 | 1.00 | 26.44 | | C |
| ANISOU | 2865 | C | LYS | A | 428 | 3294 | 3725 | 3028 | −97 | −483 | 91 | C |
| ATOM | 2866 | O | LYS | A | 428 | 4.488 | 111.032 | 48.039 | 1.00 | 32.05 | | O |
| ANISOU | 2866 | O | LYS | A | 428 | 3967 | 4384 | 3825 | −72 | −532 | 58 | O |
| ATOM | 2867 | CB | LYS | A | 428 | 5.709 | 112.701 | 50.161 | 1.00 | 26.50 | | C |
| ANISOU | 2867 | CB | LYS | A | 428 | 3321 | 3686 | 3062 | −116 | −454 | 45 | C |
| ATOM | 2868 | CG | LYS | A | 428 | 5.522 | 111.864 | 51.445 | 1.00 | 27.41 | | C |
| ANISOU | 2868 | CG | LYS | A | 428 | 3467 | 3812 | 3134 | −126 | −361 | 11 | C |
| ATOM | 2869 | CD | LYS | A | 428 | 4.764 | 112.639 | 52.526 | 1.00 | 29.38 | | C |
| ANISOU | 2869 | CD | LYS | A | 428 | 3747 | 3999 | 3417 | −126 | −283 | −60 | C |
| ATOM | 2870 | CE | LYS | A | 428 | 3.328 | 112.862 | 52.033 | 1.00 | 39.08 | | C |
| ANISOU | 2870 | CE | LYS | A | 428 | 4866 | 5166 | 4818 | −98 | −251 | −112 | C |
| ATOM | 2871 | NZ | LYS | A | 428 | 2.466 | 113.620 | 52.968 | 1.00 | 45.41 | | N |
| ANISOU | 2871 | NZ | LYS | A | 428 | 5665 | 5886 | 5704 | −92 | −138 | −197 | N |
| ATOM | 2872 | N | GLY | A | 429 | 6.075 | 109.564 | 48.594 | 1.00 | 20.90 | | N |
| ANISOU | 2872 | N | GLY | A | 429 | 2600 | 3067 | 2275 | −104 | −444 | 108 | N |
| ATOM | 2873 | CA | GLY | A | 429 | 5.304 | 108.424 | 48.101 | 1.00 | 22.13 | | C |
| ANISOU | 2873 | CA | GLY | A | 429 | 2731 | 3213 | 2464 | −90 | −445 | 87 | C |
| ATOM | 2874 | C | GLY | A | 429 | 4.480 | 107.680 | 49.148 | 1.00 | 29.67 | | C |
| ANISOU | 2874 | C | GLY | A | 429 | 3647 | 4146 | 3479 | −101 | −358 | 43 | C |
| ATOM | 2875 | O | GLY | A | 429 | 4.450 | 106.435 | 49.173 | 1.00 | 20.40 | | O |
| ANISOU | 2875 | O | GLY | A | 429 | 2475 | 2978 | 2299 | −106 | −321 | 46 | O |
| ATOM | 2876 | N | ILE | A | 430 | 3.793 | 108.448 | 49.998 | 1.00 | 29.92 | | N |
| ANISOU | 2876 | N | ILE | A | 430 | 3656 | 4136 | 3575 | −106 | −304 | 1 | N |
| ATOM | 2877 | CA | ILE | A | 430 | 2.954 | 107.911 | 51.066 | 1.00 | 20.85 | | C |
| ANISOU | 2877 | CA | ILE | A | 430 | 2495 | 2941 | 2486 | −124 | −164 | −45 | C |
| ATOM | 2878 | C | ILE | A | 430 | 1.545 | 108.474 | 50.993 | 1.00 | 34.72 | | C |
| ANISOU | 2878 | C | ILE | A | 430 | 4132 | 4613 | 4448 | −114 | −132 | −123 | C |
| ATOM | 2879 | O | ILE | A | 430 | 1.372 | 109.685 | 50.844 | 1.00 | 43.24 | | O |
| ANISOU | 2879 | O | ILE | A | 430 | 5184 | 5667 | 5578 | −93 | −187 | −144 | O |
| ATOM | 2880 | CB | ILE | A | 430 | 3.534 | 108.237 | 52.440 | 1.00 | 26.82 | | C |
| ANISOU | 2880 | CB | ILE | A | 430 | 3374 | 3700 | 3116 | −142 | −79 | −37 | C |
| ATOM | 2881 | CG1 | ILE | A | 430 | 4.980 | 107.759 | 52.529 | 1.00 | 27.81 | | C |
| ANISOU | 2881 | CG1 | ILE | A | 430 | 3589 | 3888 | 3091 | −142 | −156 | 32 | C |
| ATOM | 2882 | CG2 | ILE | A | 430 | 2.693 | 107.589 | 53.525 | 1.00 | 29.61 | | C |
| ANISOU | 2882 | CG2 | ILE | A | 430 | 3773 | 3985 | 3491 | −167 | 109 | −75 | C |
| ATOM | 2883 | CD1 | ILE | A | 430 | 5.680 | 108.151 | 53.793 | 1.00 | 29.06 | | C |
| ANISOU | 2883 | CD1 | ILE | A | 430 | 3886 | 4036 | 3121 | −152 | −152 | 37 | C |
| ATOM | 2884 | N | GLU | A | 431 | 0.534 | 107.607 | 51.061 | 1.00 | 31.60 | | N |
| ANISOU | 2884 | N | GLU | A | 431 | 3645 | 4156 | 4206 | −128 | −49 | −171 | N |
| ATOM | 2885 | CA | GLU | A | 431 | −0.845 | 108.072 | 50.975 | 1.00 | 28.63 | | C |
| ANISOU | 2885 | CA | GLU | A | 431 | 3104 | 3675 | 4099 | −116 | −23 | −261 | C |
| ATOM | 2886 | C | GLU | A | 431 | −1.731 | 107.516 | 52.069 | 1.00 | 34.10 | | C |
| ANISOU | 2886 | C | GLU | A | 431 | 3750 | 4279 | 4926 | −158 | 234 | −322 | C |
| ATOM | 2887 | O | GLU | A | 431 | −1.398 | 106.534 | 52.737 | 1.00 | 39.43 | | O |
| ANISOU | 2887 | O | GLU | A | 431 | 4533 | 4968 | 5480 | −197 | 370 | −286 | O |
| ATOM | 2888 | CB | GLU | A | 431 | −1.493 | 107.697 | 49.643 | 1.00 | 39.40 | | C |
| ANISOU | 2888 | CB | GLU | A | 431 | 4342 | 4999 | 5630 | −90 | −214 | −290 | C |
| ATOM | 2889 | CG | GLU | A | 431 | −0.798 | 108.103 | 48.362 | 1.00 | 49.56 | | C |
| ANISOU | 2889 | CG | GLU | A | 431 | 5709 | 6339 | 6782 | −51 | −452 | −233 | C |
| ATOM | 2890 | CD | GLU | A | 431 | −1.649 | 107.723 | 47.148 | 1.00 | 64.61 | | C |
| ANISOU | 2890 | CD | GLU | A | 431 | 7528 | 8169 | 8853 | −20 | −656 | −281 | C |
| ATOM | 2891 | OE1 | GLU | A | 431 | −1.561 | 108.400 | 46.101 | 1.00 | 69.02 | | O |
| ANISOU | 2891 | OE1 | GLU | A | 431 | 8148 | 8710 | 9366 | 24 | −867 | −261 | O |
| ATOM | 2892 | OE2 | GLU | A | 431 | −2.399 | 106.722 | 47.244 | 1.00 | 68.89 | | O |
| ANISOU | 2892 | OE2 | GLU | A | 431 | 7957 | 8653 | 9565 | −44 | −614 | −338 | O |
| ATOM | 2893 | N | LYS | A | 432 | −2.888 | 108.150 | 52.205 | 1.00 | 34.42 | | N |
| ANISOU | 2893 | N | LYS | A | 432 | 3628 | 4210 | 5240 | −147 | 303 | −416 | N |
| ATOM | 2894 | CA | LYS | A | 432 | −3.988 | 107.630 | 52.990 | 1.00 | 35.99 | | C |
| ANISOU | 2894 | CA | LYS | A | 432 | 3719 | 4285 | 5670 | −189 | 568 | −496 | C |
| ATOM | 2895 | C | LYS | A | 432 | −4.492 | 106.336 | 52.358 | 1.00 | 41.80 | | C |
| ANISOU | 2895 | C | LYS | A | 432 | 4329 | 4982 | 6571 | −216 | 526 | −509 | C |
| ATOM | 2896 | O | LYS | A | 432 | −4.424 | 106.162 | 51.149 | 1.00 | 45.16 | | O |
| ANISOU | 2896 | O | LYS | A | 432 | 4686 | 5437 | 7035 | −182 | 255 | −499 | O |
| ATOM | 2897 | CB | LYS | A | 432 | −5.119 | 108.663 | 53.088 | 1.00 | 28.15 | | C |
| ANISOU | 2897 | CB | LYS | A | 432 | 2525 | 3165 | 5004 | −160 | 627 | −610 | C |
| ATOM | 2898 | CG | LYS | A | 432 | −4.800 | 109.829 | 53.997 | 1.00 | 40.87 | | C |
| ANISOU | 2898 | CG | LYS | A | 432 | 4270 | 4778 | 6480 | −147 | 755 | −622 | C |
| ATOM | 2899 | CD | LYS | A | 432 | −5.936 | 110.851 | 54.055 | 1.00 | 50.62 | | C |
| ANISOU | 2899 | CD | LYS | A | 432 | 5290 | 5871 | 8073 | −108 | 818 | −744 | C |
| ATOM | 2900 | CE | LYS | A | 432 | −5.887 | 111.834 | 52.898 | 1.00 | 54.15 | | C |
| ANISOU | 2900 | CE | LYS | A | 432 | 5639 | 6330 | 8606 | −31 | 471 | −736 | C |
| ATOM | 2901 | NZ | LYS | A | 432 | −7.020 | 112.794 | 52.979 | 1.00 | 60.95 | | N |
| ANISOU | 2901 | NZ | LYS | A | 432 | 6275 | 7031 | 9852 | 18 | 515 | −859 | N |
| ATOM | 2902 | N | GLN | A | 433 | −4.966 | 105.411 | 53.178 | 1.00 | 42.44 | | N |
| ANISOU | 2902 | N | GLN | A | 433 | 4412 | 4985 | 6729 | −280 | 798 | −530 | N |
| ATOM | 2903 | CA | GLN | A | 433 | −5.403 | 104.135 | 52.648 | 1.00 | 41.90 | | C |
| ANISOU | 2903 | CA | GLN | A | 433 | 4231 | 4866 | 6822 | −315 | 769 | −543 | C |
| ATOM | 2904 | C | GLN | A | 433 | −6.848 | 104.215 | 52.213 | 1.00 | 51.69 | | C |
| ANISOU | 2904 | C | GLN | A | 433 | 5146 | 5948 | 8547 | −317 | 762 | −674 | C |
| ATOM | 2905 | O | GLN | A | 433 | −7.590 | 105.080 | 52.656 | 1.00 | 59.22 | | O |
| ANISOU | 2905 | O | GLN | A | 433 | 5968 | 6808 | 9726 | −307 | 892 | −756 | O |
| ATOM | 2906 | CB | GLN | A | 433 | −5.208 | 103.021 | 53.683 | 1.00 | 35.03 | | C |
| ANISOU | 2906 | CB | GLN | A | 433 | 3526 | 3965 | 5819 | −387 | 1059 | −493 | C |
| ATOM | 2907 | CG | GLN | A | 433 | −5.972 | 103.182 | 54.984 | 1.00 | 38.42 | | C |
| ANISOU | 2907 | CG | GLN | A | 433 | 3975 | 4259 | 6362 | −443 | 1458 | −547 | C |
| ATOM | 2908 | CD | GLN | A | 433 | −5.550 | 102.154 | 56.029 | 1.00 | 39.86 | | C |
| ANISOU | 2908 | CD | GLN | A | 433 | 4429 | 4414 | 6302 | −507 | 1717 | −465 | C |
| ATOM | 2909 | OE1 | GLN | A | 433 | −4.428 | 101.663 | 56.005 | 1.00 | 43.55 | | O |
| ANISOU | 2909 | OE1 | GLN | A | 433 | 5113 | 4991 | 6445 | −491 | 1575 | −359 | O |
| ATOM | 2910 | NE2 | GLN | A | 433 | −6.448 | 101.830 | 56.945 | 1.00 | 37.40 | | N |
| ANISOU | 2910 | NE2 | GLN | A | 433 | 4113 | 3937 | 6159 | −580 | 2102 | −516 | N |
| ATOM | 2911 | N | VAL | A | 434 | −7.244 | 103.307 | 51.336 | 1.00 | 62.85 | | N |
| ANISOU | 2911 | N | VAL | A | 434 | 6422 | 7317 | 10142 | −328 | 596 | −704 | N |
| ATOM | 2912 | CA | VAL | A | 434 | −8.644 | 103.168 | 50.957 | 1.00 | 70.58 | | C |
| ANISOU | 2912 | CA | VAL | A | 434 | 7067 | 8116 | 11636 | −341 | 570 | −840 | C |
| ATOM | 2913 | C | VAL | A | 434 | −9.111 | 101.759 | 51.320 | 1.00 | 63.00 | | C |
| ANISOU | 2913 | C | VAL | A | 434 | 6039 | 7053 | 10846 | −433 | 787 | −863 | C |
| ATOM | 2914 | O | VAL | A | 434 | −8.352 | 100.799 | 51.208 | 1.00 | 57.63 | | O |
| ANISOU | 2914 | O | VAL | A | 434 | 5544 | 6453 | 9899 | −458 | 761 | −777 | O |
| ATOM | 2915 | CB | VAL | A | 434 | −8.864 | 103.459 | 49.463 | 1.00 | 75.34 | | C |
| ANISOU | 2915 | CB | VAL | A | 434 | 7549 | 8712 | 12366 | −266 | 108 | −882 | C |
| ATOM | 2916 | CG1 | VAL | A | 434 | −10.346 | 103.486 | 49.138 | 1.00 | 73.54 | | C |
| ANISOU | 2916 | CG1 | VAL | A | 434 | 6970 | 8272 | 12699 | −260 | 36 | −1033 | C |
| ATOM | 2917 | CG2 | VAL | A | 434 | −8.221 | 104.795 | 49.100 | 1.00 | 78.87 | | C |
| ANISOU | 2917 | CG2 | VAL | A | 434 | 8129 | 9263 | 12576 | −182 | −88 | −829 | C |
| ATOM | 2918 | N | ASN | A | 435 | −10.349 | 101.666 | 51.789 | 1.00 | 70.15 | | N |
| ANISOU | 2918 | N | ASN | A | 435 | 6677 | 7766 | 12212 | −484 | 1022 | −980 | N |
| ATOM | 2919 | CA | ASN | A | 435 | −11.000 | 100.400 | 52.111 | 1.00 | 78.48 | | C |
| ANISOU | 2919 | CA | ASN | A | 435 | 7707 | 8679 | 13432 | −550 | 1218 | −1004 | C |
| ATOM | 2920 | C | ASN | A | 435 | −10.361 | 99.726 | 53.307 | 1.00 | 71.26 | | C |
| ANISOU | 2920 | C | ASN | A | 435 | 7045 | 7796 | 12234 | −641 | 1619 | −904 | C |
| ATOM | 2921 | O | ASN | A | 435 | −10.407 | 98.504 | 53.428 | 1.00 | 67.67 | | O |
| ANISOU | 2921 | O | ASN | A | 435 | 6646 | 7283 | 11784 | −702 | 1722 | −875 | O |
| ATOM | 2922 | CB | ASN | A | 435 | −10.967 | 99.437 | 50.916 | 1.00 | 86.62 | | C |
| ANISOU | 2922 | CB | ASN | A | 435 | 8670 | 9715 | 14528 | −543 | 877 | −1015 | C |
| ATOM | 2923 | CG | ASN | A | 435 | −11.691 | 99.977 | 49.703 | 1.00 | 89.71 | | C |
| ANISOU | 2923 | CG | ASN | A | 435 | 8889 | 10037 | 15160 | −441 | 459 | −1109 | C |
| ATOM | 2924 | OD1 | ASN | A | 435 | −11.110 | 100.075 | 48.619 | 1.00 | 88.93 | | O |
| ANISOU | 2924 | OD1 | ASN | A | 435 | 8852 | 10041 | 14895 | −391 | 81 | −1082 | O |
| ATOM | 2925 | ND2 | ASN | A | 435 | −12.968 | 100.318 | 49.870 | 1.00 | 90.30 | | N |
| ANISOU | 2925 | ND2 | ASN | A | 435 | 8779 | 9915 | 15615 | −407 | 525 | −1218 | N |
| ATOM | 2926 | N | ASN | A | 436 | −9.749 | 100.524 | 54.173 | 1.00 | 67.24 | | N |
| ANISOU | 2926 | N | ASN | A | 436 | 6738 | 7370 | 11439 | −636 | 1814 | −845 | N |
| ATOM | 2927 | CA | ASN | A | 436 | −9.074 | 99.994 | 55.346 | 1.00 | 64.03 | | C |
| ANISOU | 2927 | CA | ASN | A | 436 | 6685 | 6987 | 10658 | −691 | 2131 | −734 | C |
| ATOM | 2928 | C | ASN | A | 436 | −8.018 | 98.959 | 54.951 | 1.00 | 54.71 | | C |
| ANISOU | 2928 | C | ASN | A | 436 | 5719 | 5925 | 9143 | −686 | 1931 | −611 | C |
| ATOM | 2929 | O | ASN | A | 436 | −7.942 | 97.874 | 55.540 | 1.00 | 60.51 | | O |
| ANISOU | 2929 | O | ASN | A | 436 | 6602 | 6588 | 9801 | −757 | 2151 | −553 | O |
| ATOM | 2930 | CB | ASN | A | 436 | −10.104 | 99.402 | 56.317 | 1.00 | 73.45 | | C |
| ANISOU | 2930 | CB | ASN | A | 436 | 7897 | 7962 | 12049 | −753 | 2519 | −784 | C |
| ATOM | 2931 | CG | ASN | A | 436 | −9.514 | 99.067 | 57.676 | 1.00 | 78.23 | | C |
| ANISOU | 2931 | CG | ASN | A | 436 | 8919 | 8555 | 12248 | −799 | 2850 | −677 | C |
| ATOM | 2932 | OD1 | ASN | A | 436 | −8.321 | 99.268 | 57.925 | 1.00 | 78.38 | | O |
| ANISOU | 2932 | OD1 | ASN | A | 436 | 9202 | 8727 | 11853 | −790 | 2806 | −566 | O |
| ATOM | 2933 | ND2 | ASN | A | 436 | −10.356 | 98.563 | 58.570 | 1.00 | 80.50 | | N |
| ANISOU | 2933 | ND2 | ASN | A | 436 | 9292 | 8644 | 12650 | −840 | 3167 | −715 | N |
| ATOM | 2934 | N | LYS | A | 437 | −7.217 | 99.290 | 53.939 | 1.00 | 42.32 | | N |
| ANISOU | 2934 | N | LYS | A | 437 | 4170 | 4520 | 7389 | −603 | 1528 | −575 | N |
| ATOM | 2935 | CA | LYS | A | 437 | −6.126 | 98.411 | 53.514 | 1.00 | 35.68 | | C |
| ANISOU | 2935 | CA | LYS | A | 437 | 3524 | 3793 | 6240 | −585 | 1340 | −470 | C |
| ATOM | 2936 | C | LYS | A | 437 | −4.766 | 99.089 | 53.626 | 1.00 | 33.47 | | C |
| ANISOU | 2936 | C | LYS | A | 437 | 3496 | 3693 | 5527 | −515 | 1190 | −368 | C |
| ATOM | 2937 | O | LYS | A | 437 | −4.364 | 99.833 | 52.736 | 1.00 | 38.78 | | O |
| ANISOU | 2937 | O | LYS | A | 437 | 4118 | 4472 | 6147 | −447 | 910 | −375 | O |
| ATOM | 2938 | CB | LYS | A | 437 | −6.325 | 97.936 | 52.068 | 1.00 | 41.11 | | C |
| ANISOU | 2938 | CB | LYS | A | 437 | 4021 | 4489 | 7111 | −558 | 1007 | −524 | C |
| ATOM | 2939 | CG | LYS | A | 437 | −7.685 | 97.288 | 51.755 | 1.00 | 44.54 | | C |
| ANISOU | 2939 | CG | LYS | A | 437 | 4155 | 4732 | 8038 | −622 | 1063 | −647 | C |
| ATOM | 2940 | CD | LYS | A | 437 | −7.974 | 96.088 | 52.620 | 1.00 | 54.46 | | C |
| ANISOU | 2940 | CD | LYS | A | 437 | 5469 | 5858 | 9366 | −723 | 1402 | −620 | C |
| ATOM | 2941 | CE | LYS | A | 437 | −9.097 | 95.243 | 52.015 | 1.00 | 64.06 | | C |
| ANISOU | 2941 | CE | LYS | A | 437 | 6381 | 6894 | 11065 | −786 | 1369 | −740 | C |
| ATOM | 2942 | NZ | LYS | A | 437 | −10.306 | 96.048 | 51.663 | 1.00 | 64.97 | | N |
| ANISOU | 2942 | NZ | LYS | A | 437 | 6187 | 6901 | 11597 | −751 | 1288 | −882 | N |
| ATOM | 2943 | N | PRO | A | 438 | −4.046 | 98.838 | 54.724 | 1.00 | 35.24 | | N |
| ANISOU | 2943 | N | PRO | A | 438 | 4006 | 3933 | 5449 | −533 | 1368 | −274 | N |
| ATOM | 2944 | CA | PRO | A | 438 | −2.652 | 99.312 | 54.792 | 1.00 | 30.57 | | C |
| ANISOU | 2944 | CA | PRO | A | 438 | 3635 | 3497 | 4484 | −469 | 1184 | −182 | C |
| ATOM | 2945 | C | PRO | A | 438 | −1.723 | 98.483 | 53.887 | 1.00 | 29.14 | | C |
| ANISOU | 2945 | C | PRO | A | 438 | 3483 | 3406 | 4184 | −433 | 936 | −122 | C |
| ATOM | 2946 | O | PRO | A | 438 | −1.789 | 97.252 | 53.857 | 1.00 | 28.88 | | O |
| ANISOU | 2946 | O | PRO | A | 438 | 3473 | 3309 | 4189 | −466 | 988 | −99 | O |
| ATOM | 2947 | CB | PRO | A | 438 | −2.293 | 99.146 | 56.268 | 1.00 | 26.95 | | C |
| ANISOU | 2947 | CB | PRO | A | 438 | 3480 | 2986 | 3773 | −500 | 1427 | −112 | C |
| ATOM | 2948 | CG | PRO | A | 438 | −3.227 | 98.054 | 56.763 | 1.00 | 37.39 | | C |
| ANISOU | 2948 | CG | PRO | A | 438 | 4793 | 4138 | 5274 | −585 | 1722 | −126 | C |
| ATOM | 2949 | CD | PRO | A | 438 | −4.487 | 98.154 | 55.954 | 1.00 | 29.80 | | C |
| ANISOU | 2949 | CD | PRO | A | 438 | 3467 | 3102 | 4754 | −613 | 1738 | −251 | C |
| ATOM | 2950 | N | ILE | A | 439 | −0.881 | 99.179 | 53.133 | 1.00 | 30.64 | | N |
| ANISOU | 2950 | N | ILE | A | 439 | 3669 | 3726 | 4246 | −367 | 689 | −104 | N |
| ATOM | 2951 | CA | ILE | A | 439 | −0.062 | 98.559 | 52.104 | 1.00 | 25.56 | | C |
| ANISOU | 2951 | CA | ILE | A | 439 | 3029 | 3158 | 3523 | −328 | 475 | −71 | C |
| ATOM | 2952 | C | ILE | A | 439 | 1.345 | 99.150 | 52.098 | 1.00 | 31.24 | | C |
| ANISOU | 2952 | C | ILE | A | 439 | 3880 | 4000 | 3988 | −273 | 340 | 0 | C |
| ATOM | 2953 | O | ILE | A | 439 | 1.512 | 100.370 | 52.004 | 1.00 | 31.29 | | O |
| ANISOU | 2953 | O | ILE | A | 439 | 3867 | 4064 | 3959 | −249 | 274 | −12 | O |
| ATOM | 2954 | CB | ILE | A | 439 | −0.689 | 98.744 | 50.700 | 1.00 | 25.36 | | C |
| ANISOU | 2954 | CB | ILE | A | 439 | 2809 | 3132 | 3695 | −310 | 290 | −152 | C |
| ATOM | 2955 | CG1 | ILE | A | 439 | −2.096 | 98.150 | 50.649 | 1.00 | 24.31 | | C |
| ANISOU | 2955 | CG1 | ILE | A | 439 | 2497 | 2856 | 3883 | −365 | 384 | −241 | C |
| ATOM | 2956 | CG2 | ILE | A | 439 | 0.191 | 98.168 | 49.617 | 1.00 | 20.72 | | C |
| ANISOU | 2956 | CG2 | ILE | A | 439 | 2271 | 2612 | 2988 | −269 | 101 | −126 | C |
| ATOM | 2957 | CD1 | ILE | A | 439 | −2.783 | 98.414 | 49.361 | 1.00 | 24.43 | | C |
| ANISOU | 2957 | CD1 | ILE | A | 439 | 2335 | 2844 | 4103 | −340 | 155 | −331 | C |
| ATOM | 2958 | N | LEU | A | 440 | 2.346 | 98.281 | 52.232 | 1.00 | 27.56 | | N |
| ANISOU | 2958 | N | LEU | A | 440 | 3537 | 3557 | 3378 | −255 | 301 | 70 | N |
| ATOM | 2959 | CA | LEU | A | 440 | 3.731 | 98.642 | 51.978 | 1.00 | 28.93 | | C |
| ANISOU | 2959 | CA | LEU | A | 440 | 3775 | 3827 | 3389 | −201 | 153 | 121 | C |
| ATOM | 2960 | C | LEU | A | 440 | 4.030 | 98.513 | 50.480 | 1.00 | 34.32 | | C |
| ANISOU | 2960 | C | LEU | A | 440 | 4358 | 4561 | 4120 | −170 | 12 | 93 | C |
| ATOM | 2961 | O | LEU | A | 440 | 4.147 | 97.403 | 49.950 | 1.00 | 30.98 | | O |
| ANISOU | 2961 | O | LEU | A | 440 | 3933 | 4110 | 3729 | −164 | −6 | 90 | O |
| ATOM | 2962 | CB | LEU | A | 440 | 4.667 | 97.760 | 52.798 | 1.00 | 30.89 | | C |
| ANISOU | 2962 | CB | LEU | A | 440 | 4185 | 4050 | 3503 | −185 | 159 | 199 | C |
| ATOM | 2963 | CG | LEU | A | 440 | 4.563 | 97.963 | 54.304 | 1.00 | 31.40 | | C |
| ANISOU | 2963 | CG | LEU | A | 440 | 4434 | 4053 | 3443 | −207 | 271 | 237 | C |
| ATOM | 2964 | CD1 | LEU | A | 440 | 5.288 | 96.838 | 55.073 | 1.00 | 28.37 | | C |
| ANISOU | 2964 | CD1 | LEU | A | 440 | 4241 | 3601 | 2936 | −189 | 256 | 319 | C |
| ATOM | 2965 | CD2 | LEU | A | 440 | 5.121 | 99.330 | 54.675 | 1.00 | 19.97 | | C |
| ANISOU | 2965 | CD2 | LEU | A | 440 | 3023 | 2669 | 1894 | −186 | 190 | 235 | C |
| ATOM | 2966 | N | GLY | A | 441 | 4.137 | 99.648 | 49.797 | 1.00 | 29.16 | | N |
| ANISOU | 2966 | N | GLY | A | 441 | 3653 | 3967 | 3461 | −150 | −78 | 71 | N |
| ATOM | 2967 | CA | GLY | A | 441 | 4.203 | 99.653 | 48.346 | 1.00 | 17.50 | | C |
| ANISOU | 2967 | CA | GLY | A | 441 | 2131 | 2512 | 2005 | −127 | −192 | 39 | C |
| ATOM | 2968 | C | GLY | A | 441 | 5.609 | 99.850 | 47.826 | 1.00 | 16.93 | | C |
| ANISOU | 2968 | C | GLY | A | 441 | 2115 | 2506 | 1814 | −91 | −243 | 83 | C |
| ATOM | 2969 | O | GLY | A | 441 | 6.560 | 99.698 | 48.576 | 1.00 | 22.26 | | O |
| ANISOU | 2969 | O | GLY | A | 441 | 2829 | 3200 | 2429 | −80 | −216 | 132 | O |
| ATOM | 2970 | N | LEU | A | 442 | 5.730 | 100.203 | 46.549 | 1.00 | 16.91 | | N |
| ANISOU | 2970 | N | LEU | A | 442 | 2123 | 2518 | 1786 | −72 | −316 | 61 | N |
| ATOM | 2971 | CA | LEU | A | 442 | 7.029 | 100.352 | 45.902 | 1.00 | 17.45 | | C |
| ANISOU | 2971 | CA | LEU | A | 442 | 2239 | 2625 | 1767 | −47 | −311 | 92 | C |
| ATOM | 2972 | C | LEU | A | 442 | 7.970 | 101.352 | 46.598 | 1.00 | 24.99 | | C |
| ANISOU | 2972 | C | LEU | A | 442 | 3178 | 3624 | 2694 | −48 | −293 | 140 | C |
| ATOM | 2973 | O | LEU | A | 442 | 9.189 | 101.143 | 46.589 | 1.00 | 24.52 | | O |
| ANISOU | 2973 | O | LEU | A | 442 | 3112 | 3577 | 2629 | −31 | −264 | 167 | O |
| ATOM | 2974 | CB | LEU | A | 442 | 6.843 | 100.756 | 44.438 | 1.00 | 17.16 | | C |
| ANISOU | 2974 | CB | LEU | A | 442 | 2272 | 2574 | 1674 | −35 | −370 | 62 | C |
| ATOM | 2975 | CG | LEU | A | 442 | 6.367 | 99.609 | 43.535 | 1.00 | 23.18 | | C |
| ANISOU | 2975 | CG | LEU | A | 442 | 3091 | 3283 | 2436 | −25 | −409 | 7 | C |
| ATOM | 2976 | CD1 | LEU | A | 442 | 5.983 | 100.090 | 42.135 | 1.00 | 18.60 | | C |
| ANISOU | 2976 | CD1 | LEU | A | 442 | 2637 | 2664 | 1766 | −10 | −511 | −27 | C |
| ATOM | 2977 | CD2 | LEU | A | 442 | 7.451 | 98.549 | 43.463 | 1.00 | 17.92 | | C |
| ANISOU | 2977 | CD2 | LEU | A | 442 | 2447 | 2616 | 1745 | −5 | −314 | 18 | C |
| ATOM | 2978 | N | THR | A | 443 | 7.419 | 102.395 | 47.232 | 1.00 | 16.22 | | N |
| ANISOU | 2978 | N | THR | A | 443 | 2047 | 2521 | 1594 | −66 | −313 | 140 | N |
| ATOM | 2979 | CA | THR | A | 443 | 8.253 | 103.342 | 47.983 | 1.00 | 21.91 | | C |
| ANISOU | 2979 | CA | THR | A | 443 | 2761 | 3268 | 2294 | −71 | −316 | 174 | C |
| ATOM | 2980 | C | THR | A | 443 | 8.818 | 102.742 | 49.276 | 1.00 | 26.46 | | C |
| ANISOU | 2980 | C | THR | A | 443 | 3357 | 3837 | 2860 | −67 | −310 | 199 | C |
| ATOM | 2981 | O | THR | A | 443 | 9.642 | 103.366 | 49.945 | 1.00 | 30.82 | | O |
| ANISOU | 2981 | O | THR | A | 443 | 3912 | 4396 | 3401 | −66 | −352 | 219 | O |
| ATOM | 2982 | CB | THR | A | 443 | 7.481 | 104.651 | 48.329 | 1.00 | 24.20 | | C |
| ANISOU | 2982 | CB | THR | A | 443 | 3044 | 3555 | 2597 | −88 | −337 | 156 | C |
| ATOM | 2983 | OG1 | THR | A | 443 | 6.247 | 104.335 | 48.975 | 1.00 | 27.65 | | O |
| ANISOU | 2983 | OG1 | THR | A | 443 | 3468 | 3957 | 3083 | −100 | −301 | 120 | O |
| ATOM | 2984 | CG2 | THR | A | 443 | 7.169 | 105.426 | 47.080 | 1.00 | 21.45 | | C |
| ANISOU | 2984 | CG2 | THR | A | 443 | 2705 | 3198 | 2248 | −83 | −384 | 148 | C |
| ATOM | 2985 | N | PHE | A | 444 | 8.386 | 101.530 | 49.617 | 1.00 | 27.92 | | N |
| ANISOU | 2985 | N | PHE | A | 444 | 3570 | 3990 | 3049 | −63 | −277 | 198 | N |
| ATOM | 2986 | CA | PHE | A | 444 | 9.035 | 100.750 | 50.682 | 1.00 | 28.93 | | C |
| ANISOU | 2986 | CA | PHE | A | 444 | 3759 | 4086 | 3147 | −48 | −292 | 236 | C |
| ATOM | 2987 | C | PHE | A | 444 | 10.016 | 99.728 | 50.099 | 1.00 | 29.75 | | C |
| ANISOU | 2987 | C | PHE | A | 444 | 3828 | 4179 | 3298 | −10 | −314 | 251 | C |
| ATOM | 2988 | O | PHE | A | 444 | 10.916 | 99.266 | 50.798 | 1.00 | 26.69 | | O |
| ANISOU | 2988 | O | PHE | A | 444 | 3464 | 3759 | 2919 | 20 | −375 | 284 | O |
| ATOM | 2989 | CB | PHE | A | 444 | 7.999 | 100.030 | 51.557 | 1.00 | 26.52 | | C |
| ANISOU | 2989 | CB | PHE | A | 444 | 3537 | 3724 | 2817 | −71 | −216 | 238 | C |
| ATOM | 2990 | CG | PHE | A | 444 | 8.513 | 99.654 | 52.923 | 1.00 | 28.58 | | C |
| ANISOU | 2990 | CG | PHE | A | 444 | 3939 | 3933 | 2986 | −60 | −242 | 286 | C |
| ATOM | 2991 | CD1 | PHE | A | 444 | 8.753 | 100.636 | 53.886 | 1.00 | 29.20 | | C |
| ANISOU | 2991 | CD1 | PHE | A | 444 | 4107 | 4010 | 2979 | −65 | −284 | 292 | C |
| ATOM | 2992 | CD2 | PHE | A | 444 | 8.755 | 98.319 | 53.249 | 1.00 | 28.69 | | C |
| ANISOU | 2992 | CD2 | PHE | A | 444 | 4028 | 3885 | 2990 | −41 | −242 | 325 | C |
| ATOM | 2993 | CE1 | PHE | A | 444 | 9.235 | 100.300 | 55.153 | 1.00 | 28.24 | | C |
| ANISOU | 2993 | CE1 | PHE | A | 444 | 4171 | 3822 | 2738 | −50 | −345 | 335 | C |
| ATOM | 2994 | CE2 | PHE | A | 444 | 9.227 | 97.966 | 54.507 | 1.00 | 27.83 | | C |
| ANISOU | 2994 | CE2 | PHE | A | 444 | 4096 | 3706 | 2772 | −23 | −297 | 379 | C |
| ATOM | 2995 | CZ | PHE | A | 444 | 9.460 | 98.963 | 55.467 | 1.00 | 35.09 | | C |
| ANISOU | 2995 | CZ | PHE | A | 444 | 5130 | 4622 | 3582 | −27 | −357 | 384 | C |
| ATOM | 2996 | N | PHE | A | 445 | 9.825 | 99.362 | 48.831 | 1.00 | 22.93 | | N |
| ANISOU | 2996 | N | PHE | A | 445 | 2923 | 3324 | 2467 | −6 | −273 | 220 | N |
| ATOM | 2997 | CA | PHE | A | 445 | 10.762 | 98.478 | 48.141 | 1.00 | 25.97 | | C |
| ANISOU | 2997 | CA | PHE | A | 445 | 3276 | 3688 | 2902 | 31 | −257 | 216 | C |
| ATOM | 2998 | C | PHE | A | 445 | 12.016 | 99.215 | 47.667 | 1.00 | 24.71 | | C |
| ANISOU | 2998 | C | PHE | A | 445 | 3045 | 3549 | 2796 | 46 | −251 | 220 | C |
| ATOM | 2999 | O | PHE | A | 445 | 13.116 | 98.657 | 47.677 | 1.00 | 21.79 | | O |
| ANISOU | 2999 | O | PHE | A | 445 | 2615 | 3144 | 2521 | 83 | −250 | 224 | O |
| ATOM | 3000 | CB | PHE | A | 445 | 10.105 | 97.824 | 46.924 | 1.00 | 17.34 | | C |
| ANISOU | 3000 | CB | PHE | A | 445 | 2206 | 2581 | 1802 | 29 | −209 | 169 | C |
| ATOM | 3001 | CG | PHE | A | 445 | 9.159 | 96.697 | 47.251 | 1.00 | 21.26 | | C |
| ANISOU | 3001 | CG | PHE | A | 445 | 2736 | 3025 | 2316 | 18 | −202 | 155 | C |
| ATOM | 3002 | CD1 | PHE | A | 445 | 7.997 | 96.925 | 47.984 | 1.00 | 17.40 | | C |
| ANISOU | 3002 | CD1 | PHE | A | 445 | 2259 | 2524 | 1829 | −23 | −197 | 155 | C |
| ATOM | 3003 | CD2 | PHE | A | 445 | 9.398 | 95.411 | 46.757 | 1.00 | 18.03 | | C |
| ANISOU | 3003 | CD2 | PHE | A | 445 | 2342 | 2563 | 1944 | 43 | −177 | 134 | C |
| ATOM | 3004 | CE1 | PHE | A | 445 | 7.098 | 95.881 | 48.251 | 1.00 | 19.23 | | C |
| ANISOU | 3004 | CE1 | PHE | A | 445 | 2507 | 2685 | 2113 | −47 | −158 | 139 | C |
| ATOM | 3005 | CE2 | PHE | A | 445 | 8.515 | 94.354 | 47.036 | 1.00 | 19.14 | | C |
| ANISOU | 3005 | CE2 | PHE | A | 445 | 2511 | 2639 | 2124 | 23 | −164 | 120 | C |
| ATOM | 3006 | CZ | PHE | A | 445 | 7.364 | 94.587 | 47.774 | 1.00 | 19.29 | | C |
| ANISOU | 3006 | CZ | PHE | A | 445 | 2532 | 2640 | 2157 | −26 | −150 | 125 | C |
| ATOM | 3007 | N | LYS | A | 446 | 11.839 | 100.465 | 47.241 | 1.00 | 21.55 | | N |
| ANISOU | 3007 | N | LYS | A | 446 | 2641 | 3185 | 2361 | 16 | −239 | 215 | N |
| ATOM | 3008 | CA | LYS | A | 446 | 12.888 | 101.182 | 46.519 | 1.00 | 17.82 | | C |
| ANISOU | 3008 | CA | LYS | A | 446 | 2113 | 2712 | 1944 | 13 | −182 | 214 | C |
| ATOM | 3009 | C | LYS | A | 446 | 14.232 | 101.205 | 47.296 | 1.00 | 25.96 | | C |
| ANISOU | 3009 | C | LYS | A | 446 | 3031 | 3714 | 3120 | 33 | −229 | 229 | C |
| ATOM | 3010 | O | LYS | A | 446 | 14.268 | 101.403 | 48.517 | 1.00 | 18.39 | | O |
| ANISOU | 3010 | O | LYS | A | 446 | 2072 | 2751 | 2163 | 36 | −351 | 248 | O |
| ATOM | 3011 | CB | LYS | A | 446 | 12.408 | 102.601 | 46.182 | 1.00 | 21.57 | | C |
| ANISOU | 3011 | CB | LYS | A | 446 | 2623 | 3214 | 2357 | −26 | −183 | 220 | C |
| ATOM | 3012 | CG | LYS | A | 446 | 13.280 | 103.339 | 45.162 | 1.00 | 21.69 | | C |
| ANISOU | 3012 | CG | LYS | A | 446 | 2628 | 3208 | 2403 | −43 | −77 | 225 | C |
| ATOM | 3013 | CD | LYS | A | 446 | 12.435 | 104.209 | 44.204 | 1.00 | 23.63 | | C |
| ANISOU | 3013 | CD | LYS | A | 446 | 3001 | 3455 | 2523 | −66 | −62 | 229 | C |
| ATOM | 3014 | CE | LYS | A | 446 | 11.748 | 105.341 | 44.949 | 1.00 | 17.36 | | C |
| ANISOU | 3014 | CE | LYS | A | 446 | 2197 | 2681 | 1716 | −87 | −164 | 242 | C |
| ATOM | 3015 | NZ | LYS | A | 446 | 12.798 | 106.213 | 45.545 | 1.00 | 19.94 | | N |
| ANISOU | 3015 | NZ | LYS | A | 446 | 2431 | 3000 | 2146 | −112 | −155 | 261 | N |
| ATOM | 3016 | N | ASN | A | 447 | 15.315 | 100.932 | 46.568 | 1.00 | 21.56 | | N |
| ANISOU | 3016 | N | ASN | A | 447 | 2386 | 3117 | 2689 | 50 | −133 | 212 | N |
| ATOM | 3017 | CA | ASN | A | 447 | 16.681 | 100.813 | 47.107 | 1.00 | 22.99 | | C |
| ANISOU | 3017 | CA | ASN | A | 447 | 2409 | 3241 | 3086 | 78 | −181 | 208 | C |
| ATOM | 3018 | C | ASN | A | 447 | 16.811 | 99.822 | 48.275 | 1.00 | 28.46 | | C |
| ANISOU | 3018 | C | ASN | A | 447 | 3101 | 3898 | 3816 | 131 | −349 | 224 | C |
| ATOM | 3019 | O | ASN | A | 447 | 17.664 | 99.973 | 49.152 | 1.00 | 27.44 | | O |
| ANISOU | 3019 | O | ASN | A | 447 | 2884 | 3719 | 3824 | 155 | −497 | 229 | O |
| ATOM | 3020 | CB | ASN | A | 447 | 17.217 | 102.177 | 47.514 | 1.00 | 20.75 | | C |
| ANISOU | 3020 | CB | ASN | A | 447 | 2046 | 2955 | 2883 | 39 | −235 | 214 | C |
| ATOM | 3021 | CG | ASN | A | 447 | 17.204 | 103.173 | 46.361 | 1.00 | 30.35 | | C |
| ANISOU | 3021 | CG | ASN | A | 447 | 3281 | 4180 | 4070 | −15 | −60 | 212 | C |
| ATOM | 3022 | OD1 | ASN | A | 447 | 16.787 | 104.330 | 46.514 | 1.00 | 37.78 | | O |
| ANISOU | 3022 | OD1 | ASN | A | 447 | 4267 | 5148 | 4939 | −58 | −94 | 228 | O |
| ATOM | 3023 | ND2 | ASN | A | 447 | 17.644 | 102.725 | 45.197 | 1.00 | 21.59 | | N |
| ANISOU | 3023 | ND2 | ASN | A | 447 | 2166 | 3034 | 3004 | −10 | 137 | 191 | N |
| ATOM | 3024 | N | ARG | A | 448 | 15.991 | 98.775 | 48.247 | 1.00 | 24.17 | | N |
| ANISOU | 3024 | N | ARG | A | 448 | 2666 | 3358 | 3160 | 150 | −335 | 230 | N |
| ATOM | 3025 | CA | ARG | A | 448 | 16.178 | 97.648 | 49.143 | 1.00 | 27.76 | | C |
| ANISOU | 3025 | CA | ARG | A | 448 | 3146 | 3752 | 3651 | 203 | −455 | 253 | C |
| ATOM | 3026 | C | ARG | A | 448 | 16.055 | 96.359 | 48.378 | 1.00 | 26.45 | | C |
| ANISOU | 3026 | C | ARG | A | 448 | 2991 | 3549 | 3508 | 237 | −352 | 230 | C |
| ATOM | 3027 | O | ARG | A | 448 | 15.396 | 96.314 | 47.339 | 1.00 | 23.22 | | O |
| ANISOU | 3027 | O | ARG | A | 448 | 2634 | 3176 | 3012 | 208 | −215 | 199 | O |
| ATOM | 3028 | CB | ARG | A | 448 | 15.140 | 97.630 | 50.254 | 1.00 | 35.95 | | C |
| ANISOU | 3028 | CB | ARG | A | 448 | 4349 | 4802 | 4506 | 183 | −549 | 295 | C |
| ATOM | 3029 | CG | ARG | A | 448 | 15.183 | 98.760 | 51.210 | 1.00 | 41.65 | | C |
| ANISOU | 3029 | CG | ARG | A | 448 | 5111 | 5541 | 5174 | 158 | −664 | 312 | C |
| ATOM | 3030 | CD | ARG | A | 448 | 13.998 | 98.622 | 52.133 | 1.00 | 43.04 | | C |
| ANISOU | 3030 | CD | ARG | A | 448 | 5479 | 5719 | 5157 | 132 | −673 | 342 | C |
| ATOM | 3031 | NE | ARG | A | 448 | 14.273 | 99.217 | 53.426 | 1.00 | 42.90 | | N |
| ANISOU | 3031 | NE | ARG | A | 448 | 5567 | 5666 | 5068 | 135 | −827 | 363 | N |
| ATOM | 3032 | CZ | ARG | A | 448 | 13.360 | 99.847 | 54.140 | 1.00 | 39.24 | | C |
| ANISOU | 3032 | CZ | ARG | A | 448 | 5249 | 5216 | 4442 | 94 | −797 | 367 | C |
| ATOM | 3033 | NH1 | ARG | A | 448 | 12.133 | 99.964 | 53.665 | 1.00 | 35.44 | | N |
| ANISOU | 3033 | NH1 | ARG | A | 448 | 4780 | 4782 | 3902 | 49 | −629 | 350 | N |
| ATOM | 3034 | NH2 | ARG | A | 448 | 13.679 | 100.373 | 55.312 | 1.00 | 50.76 | | N |
| ANISOU | 3034 | NH2 | ARG | A | 448 | 6843 | 6630 | 5815 | 100 | −942 | 377 | N |
| ATOM | 3035 | N | GLN | A | 449 | 16.670 | 95.308 | 48.908 | 1.00 | 31.30 | | N |
| ANISOU | 3035 | N | GLN | A | 449 | 3577 | 4077 | 4237 | 301 | −440 | 242 | N |
| ATOM | 3036 | CA | GLN | A | 449 | 16.294 | 93.944 | 48.542 | 1.00 | 26.87 | | C |
| ANISOU | 3036 | CA | GLN | A | 449 | 3076 | 3467 | 3665 | 331 | −381 | 232 | C |
| ATOM | 3037 | C | GLN | A | 449 | 15.137 | 93.516 | 49.435 | 1.00 | 29.59 | | C |
| ANISOU | 3037 | C | GLN | A | 449 | 3597 | 3809 | 3836 | 305 | −447 | 283 | C |
| ATOM | 3038 | O | GLN | A | 449 | 15.230 | 93.575 | 50.661 | 1.00 | 29.20 | | O |
| ANISOU | 3038 | O | GLN | A | 449 | 3624 | 3723 | 3746 | 318 | −592 | 340 | O |
| ATOM | 3039 | CB | GLN | A | 449 | 17.472 | 92.967 | 48.674 | 1.00 | 28.76 | | C |
| ANISOU | 3039 | CB | GLN | A | 449 | 3204 | 3591 | 4131 | 419 | −439 | 221 | C |
| ATOM | 3040 | CG | GLN | A | 449 | 18.504 | 93.047 | 47.552 | 1.00 | 27.54 | | C |
| ANISOU | 3040 | CG | GLN | A | 449 | 2869 | 3408 | 4186 | 445 | −280 | 147 | C |
| ATOM | 3041 | CD | GLN | A | 449 | 19.541 | 91.937 | 47.602 | 1.00 | 35.42 | | C |
| ANISOU | 3041 | CD | GLN | A | 449 | 3740 | 4273 | 5446 | 540 | −313 | 120 | C |
| ATOM | 3042 | OE1 | GLN | A | 449 | 19.393 | 90.907 | 46.946 | 1.00 | 37.12 | | O |
| ANISOU | 3042 | OE1 | GLN | A | 449 | 3990 | 4439 | 5674 | 570 | −197 | 82 | O |
| ATOM | 3043 | NE2 | GLN | A | 449 | 20.613 | 92.156 | 48.355 | 1.00 | 40.43 | | N |
| ANISOU | 3043 | NE2 | GLN | A | 449 | 4217 | 4832 | 6312 | 592 | −487 | 130 | N |
| ATOM | 3044 | N | VAL | A | 450 | 14.021 | 93.142 | 48.825 | 1.00 | 20.93 | | N |
| ANISOU | 3044 | N | VAL | A | 450 | 2576 | 2737 | 2638 | 263 | −338 | 260 | N |
| ATOM | 3045 | CA | VAL | A | 450 | 12.903 | 92.611 | 49.598 | 1.00 | 25.20 | | C |
| ANISOU | 3045 | CA | VAL | A | 450 | 3257 | 3248 | 3069 | 230 | −351 | 299 | C |
| ATOM | 3046 | C | VAL | A | 450 | 12.819 | 91.122 | 49.323 | 1.00 | 26.08 | | C |
| ANISOU | 3046 | C | VAL | A | 450 | 3400 | 3267 | 3241 | 260 | −318 | 289 | C |
| ATOM | 3047 | O | VAL | A | 450 | 12.565 | 90.692 | 48.189 | 1.00 | 25.57 | | O |
| ANISOU | 3047 | O | VAL | A | 450 | 3305 | 3204 | 3206 | 255 | −226 | 222 | O |
| ATOM | 3048 | CB | VAL | A | 450 | 11.561 | 93.265 | 49.254 | 1.00 | 23.97 | | C |
| ANISOU | 3048 | CB | VAL | A | 450 | 3137 | 3161 | 2810 | 153 | −272 | 271 | C |
| ATOM | 3049 | CG1 | VAL | A | 450 | 10.497 | 92.699 | 50.164 | 1.00 | 27.87 | | C |
| ANISOU | 3049 | CG1 | VAL | A | 450 | 3749 | 3597 | 3244 | 113 | −249 | 307 | C |
| ATOM | 3050 | CG2 | VAL | A | 450 | 11.638 | 94.751 | 49.458 | 1.00 | 26.96 | | C |
| ANISOU | 3050 | CG2 | VAL | A | 450 | 3485 | 3620 | 3137 | 127 | −300 | 276 | C |
| ATOM | 3051 | N | ILE | A | 451 | 13.054 | 90.335 | 50.359 | 1.00 | 28.04 | | N |
| ANISOU | 3051 | N | ILE | A | 451 | 3738 | 3419 | 3499 | 295 | −404 | 354 | N |
| ATOM | 3052 | CA | ILE | A | 451 | 13.322 | 88.923 | 50.172 | 1.00 | 28.95 | | C |
| ANISOU | 3052 | CA | ILE | A | 451 | 3869 | 3421 | 3711 | 345 | −401 | 352 | C |
| ATOM | 3053 | C | ILE | A | 451 | 12.157 | 88.060 | 50.632 | 1.00 | 27.25 | | C |
| ANISOU | 3053 | C | ILE | A | 451 | 3802 | 3131 | 3421 | 293 | −342 | 386 | C |
| ATOM | 3054 | O | ILE | A | 451 | 11.808 | 88.046 | 51.806 | 1.00 | 30.23 | | O |
| ANISOU | 3054 | O | ILE | A | 451 | 4329 | 3458 | 3699 | 272 | −378 | 466 | O |
| ATOM | 3055 | CB | ILE | A | 451 | 14.591 | 88.537 | 50.913 | 1.00 | 30.76 | | C |
| ANISOU | 3055 | CB | ILE | A | 451 | 4083 | 3556 | 4048 | 438 | −563 | 402 | C |
| ATOM | 3056 | CG1 | ILE | A | 451 | 15.749 | 89.403 | 50.416 | 1.00 | 26.90 | | C |
| ANISOU | 3056 | CG1 | ILE | A | 451 | 3401 | 3122 | 3698 | 479 | −597 | 353 | C |
| ATOM | 3057 | CG2 | ILE | A | 451 | 14.884 | 87.042 | 50.743 | 1.00 | 30.46 | | C |
| ANISOU | 3057 | CG2 | ILE | A | 451 | 4063 | 3381 | 4131 | 501 | −568 | 401 | C |
| ATOM | 3058 | CD1 | ILE | A | 451 | 16.842 | 89.589 | 51.448 | 1.00 | 26.13 | | C |
| ANISOU | 3058 | CD1 | ILE | A | 451 | 3278 | 2951 | 3698 | 549 | −822 | 403 | C |
| ATOM | 3059 | N | PHE | A | 452 | 11.545 | 87.356 | 49.690 | 1.00 | 30.24 | | N |
| ANISOU | 3059 | N | PHE | A | 452 | 4153 | 3487 | 3848 | 268 | −242 | 319 | N |
| ATOM | 3060 | CA | PHE | A | 452 | 10.410 | 86.488 | 49.993 | 1.00 | 29.23 | | C |
| ANISOU | 3060 | CA | PHE | A | 452 | 4128 | 3270 | 3708 | 207 | −170 | 334 | C |
| ATOM | 3061 | C | PHE | A | 452 | 10.882 | 85.062 | 50.190 | 1.00 | 33.01 | | C |
| ANISOU | 3061 | C | PHE | A | 452 | 4670 | 3598 | 4276 | 263 | −198 | 365 | C |
| ATOM | 3062 | O | PHE | A | 452 | 11.023 | 84.300 | 49.230 | 1.00 | 29.31 | | O |
| ANISOU | 3062 | O | PHE | A | 452 | 4143 | 3087 | 3908 | 289 | −165 | 290 | O |
| ATOM | 3063 | CB | PHE | A | 452 | 9.360 | 86.564 | 48.882 | 1.00 | 25.15 | | C |
| ANISOU | 3063 | CB | PHE | A | 452 | 3544 | 2794 | 3217 | 140 | −85 | 233 | C |
| ATOM | 3064 | CG | PHE | A | 452 | 8.764 | 87.937 | 48.711 | 1.00 | 22.14 | | C |
| ANISOU | 3064 | CG | PHE | A | 452 | 3111 | 2537 | 2765 | 88 | −73 | 207 | C |
| ATOM | 3065 | CD1 | PHE | A | 452 | 9.467 | 88.945 | 48.053 | 1.00 | 21.41 | | C |
| ANISOU | 3065 | CD1 | PHE | A | 452 | 2943 | 2554 | 2636 | 121 | −109 | 176 | C |
| ATOM | 3066 | CD2 | PHE | A | 452 | 7.512 | 88.226 | 49.235 | 1.00 | 22.10 | | C |
| ANISOU | 3066 | CD2 | PHE | A | 452 | 3128 | 2519 | 2751 | 5 | −10 | 214 | C |
| ATOM | 3067 | CE1 | PHE | A | 452 | 8.924 | 90.223 | 47.916 | 1.00 | 26.08 | | C |
| ANISOU | 3067 | CE1 | PHE | A | 452 | 3500 | 3244 | 3166 | 78 | −109 | 159 | C |
| ATOM | 3068 | CE2 | PHE | A | 452 | 6.962 | 89.500 | 49.097 | 1.00 | 32.12 | | C |
| ANISOU | 3068 | CE2 | PHE | A | 452 | 4338 | 3885 | 3981 | −33 | −8 | 185 | C |
| ATOM | 3069 | CZ | PHE | A | 452 | 7.667 | 90.502 | 48.443 | 1.00 | 22.71 | | C |
| ANISOU | 3069 | CZ | PHE | A | 452 | 3088 | 2805 | 2735 | 6 | −71 | 162 | C |
| ATOM | 3070 | N | ASP | A | 453 | 11.147 | 84.723 | 51.447 | 1.00 | 31.72 | | N |
| ANISOU | 3070 | N | ASP | A | 453 | 4653 | 3338 | 4060 | 287 | −268 | 475 | N |
| ATOM | 3071 | CA | ASP | A | 453 | 11.615 | 83.395 | 51.819 | 1.00 | 32.77 | | C |
| ANISOU | 3071 | CA | ASP | A | 453 | 4881 | 3302 | 4269 | 349 | −324 | 528 | C |
| ATOM | 3072 | C | ASP | A | 453 | 10.402 | 82.516 | 52.034 | 1.00 | 33.99 | | C |
| ANISOU | 3072 | C | ASP | A | 453 | 5156 | 3345 | 4414 | 262 | −188 | 547 | C |
| ATOM | 3073 | O | ASP | A | 453 | 9.904 | 82.404 | 53.153 | 1.00 | 32.15 | | O |
| ANISOU | 3073 | O | ASP | A | 453 | 5117 | 3028 | 4071 | 216 | −151 | 647 | O |
| ATOM | 3074 | CB | ASP | A | 453 | 12.472 | 83.460 | 53.089 | 1.00 | 28.96 | | C |
| ANISOU | 3074 | CB | ASP | A | 453 | 4540 | 2742 | 3719 | 421 | −500 | 643 | C |
| ATOM | 3075 | CG | ASP | A | 453 | 13.206 | 82.155 | 53.383 | 1.00 | 42.10 | | C |
| ANISOU | 3075 | CG | ASP | A | 453 | 6282 | 4220 | 5494 | 517 | −614 | 696 | C |
| ATOM | 3076 | OD1 | ASP | A | 453 | 12.760 | 81.078 | 52.926 | 1.00 | 41.47 | | O |
| ANISOU | 3076 | OD1 | ASP | A | 453 | 6217 | 4044 | 5497 | 500 | −516 | 672 | O |
| ATOM | 3077 | OD2 | ASP | A | 453 | 14.234 | 82.210 | 54.095 | 1.00 | 42.60 | | O |
| ANISOU | 3077 | OD2 | ASP | A | 453 | 6394 | 4218 | 5574 | 613 | −826 | 759 | O |
| ATOM | 3078 | N | ILE | A | 454 | 9.933 | 81.897 | 50.954 | 1.00 | 38.08 | | N |
| ANISOU | 3078 | N | ILE | A | 454 | 5574 | 3846 | 5049 | 234 | −106 | 447 | N |
| ATOM | 3079 | CA | ILE | A | 454 | 8.724 | 81.067 | 50.977 | 1.00 | 35.69 | | C |
| ANISOU | 3079 | CA | ILE | A | 454 | 5333 | 3428 | 4798 | 138 | 23 | 437 | C |
| ATOM | 3080 | C | ILE | A | 454 | 8.880 | 79.839 | 51.851 | 1.00 | 35.69 | | C |
| ANISOU | 3080 | C | ILE | A | 454 | 5520 | 3223 | 4818 | 159 | 21 | 544 | C |
| ATOM | 3081 | O | ILE | A | 454 | 7.937 | 79.394 | 52.490 | 1.00 | 41.58 | | O |
| ANISOU | 3081 | O | ILE | A | 454 | 6392 | 3854 | 5553 | 68 | 149 | 598 | O |
| ATOM | 3082 | CB | ILE | A | 454 | 8.357 | 80.616 | 49.569 | 1.00 | 38.65 | | C |
| ANISOU | 3082 | CB | ILE | A | 454 | 5574 | 3810 | 5302 | 121 | 54 | 292 | C |
| ATOM | 3083 | CG1 | ILE | A | 454 | 7.870 | 81.813 | 48.771 | 1.00 | 31.27 | | C |
| ANISOU | 3083 | CG1 | ILE | A | 454 | 4512 | 3045 | 4326 | 78 | 61 | 199 | C |
| ATOM | 3084 | CG2 | ILE | A | 454 | 7.304 | 79.482 | 49.586 | 1.00 | 36.98 | | C |
| ANISOU | 3084 | CG2 | ILE | A | 454 | 5414 | 3430 | 5208 | 35 | 152 | 274 | C |
| ATOM | 3085 | CD1 | ILE | A | 454 | 7.771 | 81.513 | 47.321 | 1.00 | 43.04 | | C |
| ANISOU | 3085 | CD1 | ILE | A | 454 | 5921 | 4546 | 5885 | 86 | 45 | 56 | C |
| ATOM | 3086 | N | GLN | A | 455 | 10.081 | 79.291 | 51.864 | 1.00 | 31.40 | | N |
| ANISOU | 3086 | N | GLN | A | 455 | 4991 | 2616 | 4323 | 281 | −116 | 572 | N |
| ATOM | 3087 | CA | GLN | A | 455 | 10.357 | 78.084 | 52.627 | 1.00 | 39.52 | | C |
| ANISOU | 3087 | CA | GLN | A | 455 | 6207 | 3429 | 5380 | 323 | −158 | 676 | C |
| ATOM | 3088 | C | GLN | A | 455 | 10.223 | 78.321 | 54.148 | 1.00 | 44.94 | | C |
| ANISOU | 3088 | C | GLN | A | 455 | 7162 | 4038 | 5874 | 301 | −179 | 838 | C |
| ATOM | 3089 | O | GLN | A | 455 | 9.668 | 77.494 | 54.860 | 1.00 | 35.98 | | O |
| ANISOU | 3089 | O | GLN | A | 455 | 6245 | 2724 | 4703 | 251 | −91 | 930 | O |
| ATOM | 3090 | CB | GLN | A | 455 | 11.746 | 77.576 | 52.251 | 1.00 | 47.32 | | C |
| ANISOU | 3090 | CB | GLN | A | 455 | 7112 | 4366 | 6501 | 475 | −324 | 655 | C |
| ATOM | 3091 | CG | GLN | A | 455 | 12.313 | 76.495 | 53.127 | 1.00 | 57.29 | | C |
| ANISOU | 3091 | CG | GLN | A | 455 | 8568 | 5403 | 7796 | 558 | −447 | 776 | C |
| ATOM | 3092 | CD | GLN | A | 455 | 13.768 | 76.221 | 52.794 | 1.00 | 70.33 | | C |
| ANISOU | 3092 | CD | GLN | A | 455 | 10083 | 7013 | 9625 | 722 | −633 | 741 | C |
| ATOM | 3093 | OE1 | GLN | A | 455 | 14.274 | 76.660 | 51.756 | 1.00 | 69.60 | | O |
| ANISOU | 3093 | OE1 | GLN | A | 455 | 9750 | 7046 | 9650 | 759 | −606 | 611 | O |
| ATOM | 3094 | NE2 | GLN | A | 455 | 14.454 | 75.504 | 53.678 | 1.00 | 79.43 | | N |
| ANISOU | 3094 | NE2 | GLN | A | 455 | 11397 | 7972 | 10811 | 822 | −817 | 857 | N |
| ATOM | 3095 | N | LYS | A | 456 | 10.686 | 79.469 | 54.643 | 1.00 | 40.52 | | N |
| ANISOU | 3095 | N | LYS | A | 456 | 6613 | 3602 | 5179 | 331 | −279 | 869 | N |
| ATOM | 3096 | CA | LYS | A | 456 | 10.648 | 79.715 | 56.085 | 1.00 | 37.47 | | C |
| ANISOU | 3096 | CA | LYS | A | 456 | 6531 | 3131 | 4574 | 321 | −321 | 1012 | C |
| ATOM | 3097 | C | LYS | A | 456 | 9.530 | 80.686 | 56.504 | 1.00 | 47.44 | | C |
| ANISOU | 3097 | C | LYS | A | 456 | 7854 | 4486 | 5686 | 192 | −122 | 1010 | C |
| ATOM | 3098 | O | LYS | A | 456 | 9.517 | 81.176 | 57.639 | 1.00 | 53.50 | | O |
| ANISOU | 3098 | O | LYS | A | 456 | 8874 | 5216 | 6238 | 181 | −140 | 1106 | O |
| ATOM | 3099 | CB | LYS | A | 456 | 11.994 | 80.254 | 56.559 | 1.00 | 37.21 | | C |
| ANISOU | 3099 | CB | LYS | A | 456 | 6519 | 3123 | 4495 | 452 | −610 | 1053 | C |
| ATOM | 3100 | CG | LYS | A | 456 | 13.115 | 79.229 | 56.590 | 1.00 | 40.42 | | C |
| ANISOU | 3100 | CG | LYS | A | 456 | 6942 | 3369 | 5048 | 593 | −832 | 1092 | C |
| ATOM | 3101 | CD | LYS | A | 456 | 14.376 | 79.834 | 57.180 | 1.00 | 50.20 | | C |
| ANISOU | 3101 | CD | LYS | A | 456 | 8192 | 4609 | 6274 | 715 | −1145 | 1128 | C |
| ATOM | 3102 | CE | LYS | A | 456 | 15.473 | 78.807 | 57.320 | 1.00 | 62.59 | | C |
| ANISOU | 3102 | CE | LYS | A | 456 | 9775 | 5984 | 8024 | 866 | −1394 | 1169 | C |
| ATOM | 3103 | NZ | LYS | A | 456 | 15.822 | 78.234 | 55.986 | 1.00 | 69.56 | | N |
| ANISOU | 3103 | NZ | LYS | A | 456 | 10329 | 6895 | 9207 | 909 | −1308 | 1040 | N |
| ATOM | 3104 | N | ASN | A | 457 | 8.603 | 80.964 | 55.588 | 1.00 | 44.31 | | N |
| ANISOU | 3104 | N | ASN | A | 457 | 7235 | 4194 | 5406 | 100 | 53 | 894 | N |
| ATOM | 3105 | CA | ASN | A | 457 | 7.462 | 81.841 | 55.860 | 1.00 | 37.90 | | C |
| ANISOU | 3105 | CA | ASN | A | 457 | 6422 | 3454 | 4526 | −20 | 252 | 870 | C |
| ATOM | 3106 | C | ASN | A | 457 | 7.867 | 83.216 | 56.376 | 1.00 | 34.90 | | C |
| ANISOU | 3106 | C | ASN | A | 457 | 6074 | 3212 | 3974 | 7 | 164 | 884 | C |
| ATOM | 3107 | O | ASN | A | 457 | 7.286 | 83.747 | 57.329 | 1.00 | 33.53 | | O |
| ANISOU | 3107 | O | ASN | A | 457 | 6090 | 3009 | 3642 | −57 | 290 | 937 | O |
| ATOM | 3108 | CB | ASN | A | 457 | 6.495 | 81.177 | 56.839 | 1.00 | 43.96 | | C |
| ANISOU | 3108 | CB | ASN | A | 457 | 7446 | 4025 | 5231 | −122 | 482 | 961 | C |
| ATOM | 3109 | CG | ASN | A | 457 | 5.840 | 79.950 | 56.248 | 1.00 | 72.26 | | C |
| ANISOU | 3109 | CG | ASN | A | 457 | 10952 | 7474 | 9031 | −182 | 608 | 923 | C |
| ATOM | 3110 | OD1 | ASN | A | 457 | 5.033 | 80.063 | 55.320 | 1.00 | 79.42 | | O |
| ANISOU | 3110 | OD1 | ASN | A | 457 | 11606 | 8444 | 10127 | −253 | 701 | 796 | O |
| ATOM | 3111 | ND2 | ASN | A | 457 | 6.175 | 78.764 | 56.778 | 1.00 | 81.61 | | N |
| ANISOU | 3111 | ND2 | ASN | A | 457 | 12361 | 8454 | 10194 | −152 | 590 | 1029 | N |
| ATOM | 3112 | N | ARG | A | 458 | 8.860 | 83.810 | 55.740 | 1.00 | 30.20 | | N |
| ANISOU | 3112 | N | ARG | A | 458 | 5299 | 2755 | 3420 | 97 | −32 | 830 | N |
| ATOM | 3113 | CA | ARG | A | 458 | 9.284 | 85.112 | 56.193 | 1.00 | 33.50 | | C |
| ANISOU | 3113 | CA | ARG | A | 458 | 5733 | 3292 | 3704 | 119 | −129 | 836 | C |
| ATOM | 3114 | C | ARG | A | 458 | 9.651 | 86.024 | 55.049 | 1.00 | 27.60 | | C |
| ANISOU | 3114 | C | ARG | A | 458 | 4687 | 2733 | 3065 | 142 | −190 | 723 | C |
| ATOM | 3115 | O | ARG | A | 458 | 9.892 | 85.573 | 53.938 | 1.00 | 26.99 | | O |
| ANISOU | 3115 | O | ARG | A | 458 | 4423 | 2685 | 3145 | 170 | −201 | 649 | O |
| ATOM | 3116 | CB | ARG | A | 458 | 10.458 | 84.967 | 57.138 | 1.00 | 30.99 | | C |
| ANISOU | 3116 | CB | ARG | A | 458 | 5618 | 2885 | 3272 | 222 | −369 | 935 | C |
| ATOM | 3117 | CG | ARG | A | 458 | 11.687 | 84.548 | 56.430 | 1.00 | 30.89 | | C |
| ANISOU | 3117 | CG | ARG | A | 458 | 5419 | 2879 | 3441 | 338 | −575 | 901 | C |
| ATOM | 3118 | CD | ARG | A | 458 | 12.766 | 84.184 | 57.417 | 1.00 | 39.25 | | C |
| ANISOU | 3118 | CD | ARG | A | 458 | 6678 | 3796 | 4438 | 447 | −844 | 1000 | C |
| ATOM | 3119 | NE | ARG | A | 458 | 13.902 | 83.602 | 56.721 | 1.00 | 39.74 | | N |
| ANISOU | 3119 | NE | ARG | A | 458 | 6530 | 3826 | 4743 | 562 | −1014 | 959 | N |
| ATOM | 3120 | CZ | ARG | A | 458 | 15.077 | 83.372 | 57.282 | 1.00 | 42.70 | | C |
| ANISOU | 3120 | CZ | ARG | A | 458 | 6957 | 4090 | 5177 | 684 | −1305 | 1008 | C |
| ATOM | 3121 | NH1 | ARG | A | 458 | 15.275 | 83.703 | 58.552 | 1.00 | 39.48 | | N |
| ANISOU | 3121 | NH1 | ARG | A | 458 | 6842 | 3598 | 4562 | 706 | −1490 | 1105 | N |
| ATOM | 3122 | NH2 | ARG | A | 458 | 16.051 | 82.830 | 56.561 | 1.00 | 46.39 | | N |
| ANISOU | 3122 | NH2 | ARG | A | 458 | 7187 | 4519 | 5920 | 786 | −1414 | 951 | N |
| ATOM | 3123 | N | ILE | A | 459 | 9.691 | 87.317 | 55.333 | 1.00 | 29.25 | | N |
| ANISOU | 3123 | N | ILE | A | 459 | 4880 | 3056 | 3177 | 128 | −217 | 710 | N |
| ATOM | 3124 | CA | ILE | A | 459 | 10.108 | 88.309 | 54.348 | 1.00 | 30.59 | | C |
| ANISOU | 3124 | CA | ILE | A | 459 | 4805 | 3391 | 3428 | 148 | −274 | 620 | C |
| ATOM | 3125 | C | ILE | A | 459 | 11.290 | 89.072 | 54.912 | 1.00 | 32.67 | | C |
| ANISOU | 3125 | C | ILE | A | 459 | 5092 | 3686 | 3635 | 220 | −476 | 652 | C |
| ATOM | 3126 | O | ILE | A | 459 | 11.288 | 89.413 | 56.093 | 1.00 | 29.53 | | O |
| ANISOU | 3126 | O | ILE | A | 459 | 4908 | 3237 | 3074 | 216 | −532 | 719 | O |
| ATOM | 3127 | CB | ILE | A | 459 | 8.958 | 89.263 | 53.986 | 1.00 | 28.71 | | C |
| ANISOU | 3127 | CB | ILE | A | 459 | 4479 | 3254 | 3175 | 57 | −122 | 555 | C |
| ATOM | 3128 | CG1 | ILE | A | 459 | 7.859 | 88.476 | 53.257 | 1.00 | 30.85 | | C |
| ANISOU | 3128 | CG1 | ILE | A | 459 | 4674 | 3480 | 3568 | −7 | 29 | 499 | C |
| ATOM | 3129 | CG2 | ILE | A | 459 | 9.455 | 90.422 | 53.140 | 1.00 | 22.67 | | C |
| ANISOU | 3129 | CG2 | ILE | A | 459 | 3526 | 2641 | 2448 | 80 | −194 | 486 | C |
| ATOM | 3130 | CD1 | ILE | A | 459 | 6.537 | 89.231 | 53.153 | 1.00 | 30.63 | | C |
| ANISOU | 3130 | CD1 | ILE | A | 459 | 4577 | 3494 | 3567 | −99 | 173 | 441 | C |
| ATOM | 3131 | N | GLY | A | 460 | 12.307 | 89.301 | 54.083 | 1.00 | 31.18 | | N |
| ANISOU | 3131 | N | GLY | A | 460 | 4696 | 3560 | 3589 | 284 | −579 | 599 | N |
| ATOM | 3132 | CA | GLY | A | 460 | 13.512 | 89.974 | 54.526 | 1.00 | 29.77 | | C |
| ANISOU | 3132 | CA | GLY | A | 460 | 4483 | 3392 | 3436 | 352 | −784 | 614 | C |
| ATOM | 3133 | C | GLY | A | 460 | 13.676 | 91.351 | 53.901 | 1.00 | 30.66 | | C |
| ANISOU | 3133 | C | GLY | A | 460 | 4417 | 3650 | 3581 | 323 | −760 | 545 | C |
| ATOM | 3134 | O | GLY | A | 460 | 13.196 | 91.615 | 52.795 | 1.00 | 23.61 | | O |
| ANISOU | 3134 | O | GLY | A | 460 | 3387 | 2847 | 2736 | 282 | −613 | 479 | O |
| ATOM | 3135 | N | PHE | A | 461 | 14.341 | 92.236 | 54.631 | 1.00 | 25.76 | | N |
| ANISOU | 3135 | N | PHE | A | 461 | 3823 | 3037 | 2926 | 344 | −921 | 563 | N |
| ATOM | 3136 | CA | PHE | A | 461 | 14.599 | 93.593 | 54.149 | 1.00 | 25.54 | | C |
| ANISOU | 3136 | CA | PHE | A | 461 | 3637 | 3125 | 2940 | 316 | −912 | 506 | C |
| ATOM | 3137 | C | PHE | A | 461 | 16.048 | 93.931 | 54.399 | 1.00 | 27.19 | | C |
| ANISOU | 3137 | C | PHE | A | 461 | 3729 | 3292 | 3311 | 386 | −1130 | 497 | C |
| ATOM | 3138 | O | PHE | A | 461 | 16.574 | 93.641 | 55.468 | 1.00 | 31.38 | | O |
| ANISOU | 3138 | O | PHE | A | 461 | 4396 | 3715 | 3811 | 439 | −1347 | 547 | O |
| ATOM | 3139 | CB | PHE | A | 461 | 13.711 | 94.631 | 54.849 | 1.00 | 23.80 | | C |
| ANISOU | 3139 | CB | PHE | A | 461 | 3560 | 2957 | 2524 | 246 | −866 | 515 | C |
| ATOM | 3140 | CG | PHE | A | 461 | 12.242 | 94.396 | 54.685 | 1.00 | 26.14 | | C |
| ANISOU | 3140 | CG | PHE | A | 461 | 3936 | 3276 | 2719 | 174 | −651 | 511 | C |
| ATOM | 3141 | CD1 | PHE | A | 461 | 11.568 | 94.879 | 53.578 | 1.00 | 28.36 | | C |
| ANISOU | 3141 | CD1 | PHE | A | 461 | 4065 | 3654 | 3056 | 127 | −508 | 448 | C |
| ATOM | 3142 | CD2 | PHE | A | 461 | 11.520 | 93.720 | 55.658 | 1.00 | 32.81 | | C |
| ANISOU | 3142 | CD2 | PHE | A | 461 | 5017 | 4025 | 3424 | 151 | −594 | 568 | C |
| ATOM | 3143 | CE1 | PHE | A | 461 | 10.201 | 94.678 | 53.431 | 1.00 | 27.51 | | C |
| ANISOU | 3143 | CE1 | PHE | A | 461 | 3995 | 3546 | 2911 | 64 | −344 | 430 | C |
| ATOM | 3144 | CE2 | PHE | A | 461 | 10.140 | 93.496 | 55.510 | 1.00 | 27.22 | | C |
| ANISOU | 3144 | CE2 | PHE | A | 461 | 4341 | 3315 | 2685 | 76 | −374 | 552 | C |
| ATOM | 3145 | CZ | PHE | A | 461 | 9.488 | 93.977 | 54.401 | 1.00 | 27.09 | | C |
| ANISOU | 3145 | CZ | PHE | A | 461 | 4128 | 3395 | 2769 | 36 | −266 | 477 | C |
| ATOM | 3146 | N | VAL | A | 462 | 16.690 | 94.558 | 53.423 | 1.00 | 26.52 | | N |
| ANISOU | 3146 | N | VAL | A | 462 | 3401 | 3271 | 3405 | 385 | −1077 | 433 | N |
| ATOM | 3147 | CA | VAL | A | 462 | 18.056 | 95.029 | 53.602 | 1.00 | 26.60 | | C |
| ANISOU | 3147 | CA | VAL | A | 462 | 3245 | 3231 | 3631 | 435 | −1259 | 408 | C |
| ATOM | 3148 | C | VAL | A | 462 | 18.347 | 96.129 | 52.560 | 1.00 | 33.68 | | C |
| ANISOU | 3148 | C | VAL | A | 462 | 3929 | 4220 | 4648 | 386 | −1111 | 344 | C |
| ATOM | 3149 | O | VAL | A | 462 | 17.893 | 96.040 | 51.407 | 1.00 | 25.31 | | O |
| ANISOU | 3149 | O | VAL | A | 462 | 2814 | 3225 | 3577 | 353 | −882 | 313 | O |
| ATOM | 3150 | CB | VAL | A | 462 | 19.054 | 93.850 | 53.504 | 1.00 | 31.31 | | C |
| ANISOU | 3150 | CB | VAL | A | 462 | 3729 | 3701 | 4467 | 533 | −1364 | 405 | C |
| ATOM | 3151 | CG1 | VAL | A | 462 | 19.116 | 93.291 | 52.072 | 1.00 | 31.47 | | C |
| ANISOU | 3151 | CG1 | VAL | A | 462 | 3577 | 3749 | 4630 | 535 | −1113 | 347 | C |
| ATOM | 3152 | CG2 | VAL | A | 462 | 20.419 | 94.237 | 54.029 | 1.00 | 29.21 | | C |
| ANISOU | 3152 | CG2 | VAL | A | 462 | 3307 | 3340 | 4453 | 596 | −1627 | 383 | C |
| ATOM | 3153 | N | ASP | A | 463 | 19.049 | 97.186 | 52.977 | 1.00 | 25.48 | | N |
| ANISOU | 3153 | N | ASP | A | 463 | 2803 | 3173 | 3704 | 377 | −1248 | 325 | N |
| ATOM | 3154 | CA | ASP | A | 463 | 19.413 | 98.267 | 52.056 | 1.00 | 29.99 | | C |
| ANISOU | 3154 | CA | ASP | A | 463 | 3185 | 3805 | 4405 | 324 | −1104 | 273 | C |
| ATOM | 3155 | C | ASP | A | 463 | 20.354 | 97.779 | 50.940 | 1.00 | 27.56 | | C |
| ANISOU | 3155 | C | ASP | A | 463 | 2639 | 3450 | 4384 | 356 | −955 | 222 | C |
| ATOM | 3156 | O | ASP | A | 463 | 21.306 | 97.034 | 51.182 | 1.00 | 29.11 | | O |
| ANISOU | 3156 | O | ASP | A | 463 | 2706 | 3535 | 4820 | 432 | −1076 | 206 | O |
| ATOM | 3157 | CB | ASP | A | 463 | 20.070 | 99.433 | 52.816 | 1.00 | 41.00 | | C |
| ANISOU | 3157 | CB | ASP | A | 463 | 4522 | 5170 | 5886 | 307 | −1301 | 256 | C |
| ATOM | 3158 | CG | ASP | A | 463 | 19.133 | 100.082 | 53.838 | 1.00 | 46.91 | | C |
| ANISOU | 3158 | CG | ASP | A | 463 | 5526 | 5961 | 6338 | 268 | −1400 | 289 | C |
| ATOM | 3159 | OD1 | ASP | A | 463 | 17.902 | 100.102 | 53.611 | 1.00 | 50.70 | | O |
| ANISOU | 3159 | OD1 | ASP | A | 463 | 6153 | 6525 | 6586 | 225 | −1230 | 311 | O |
| ATOM | 3160 | OD2 | ASP | A | 463 | 19.633 | 100.560 | 54.883 | 1.00 | 48.50 | | O |
| ANISOU | 3160 | OD2 | ASP | A | 463 | 5781 | 6095 | 6551 | 284 | −1654 | 285 | O |
| ATOM | 3161 | N | ALA | A | 464 | 20.097 | 98.201 | 49.711 | 1.00 | 27.14 | | N |
| ANISOU | 3161 | N | ALA | A | 464 | 2539 | 3463 | 4309 | 303 | −689 | 193 | N |
| ATOM | 3162 | CA | ALA | A | 464 | 20.876 | 97.682 | 48.595 | 1.00 | 30.37 | | C |
| ANISOU | 3162 | CA | ALA | A | 464 | 2779 | 3817 | 4941 | 329 | −486 | 140 | C |
| ATOM | 3163 | C | ALA | A | 464 | 21.120 | 98.661 | 47.464 | 1.00 | 31.73 | | C |
| ANISOU | 3163 | C | ALA | A | 464 | 2873 | 4018 | 5163 | 261 | −233 | 105 | C |
| ATOM | 3164 | O | ALA | A | 464 | 20.318 | 99.557 | 47.197 | 1.00 | 28.02 | | O |
| ANISOU | 3164 | O | ALA | A | 464 | 2534 | 3636 | 4478 | 194 | −170 | 129 | O |
| ATOM | 3165 | CB | ALA | A | 464 | 20.200 | 96.457 | 48.030 | 1.00 | 30.57 | | C |
| ANISOU | 3165 | CB | ALA | A | 464 | 2929 | 3851 | 4835 | 358 | −367 | 139 | C |
| ATOM | 3166 | N | ASN | A | 465 | 22.238 | 98.461 | 46.783 | 1.00 | 33.51 | | N |
| ANISOU | 3166 | N | ASN | A | 465 | 2893 | 4151 | 5688 | 281 | −73 | 49 | N |
| ATOM | 3167 | CA | ASN | A | 465 | 22.425 | 99.054 | 45.478 | 1.00 | 33.22 | | C |
| ANISOU | 3167 | CA | ASN | A | 465 | 2845 | 4114 | 5663 | 221 | 253 | 17 | C |
| ATOM | 3168 | C | ASN | A | 465 | 21.824 | 98.153 | 44.414 | 1.00 | 35.71 | | C |
| ANISOU | 3168 | C | ASN | A | 465 | 3334 | 4446 | 5787 | 237 | 466 | −2 | C |
| ATOM | 3169 | O | ASN | A | 465 | 22.503 | 97.261 | 43.891 | 1.00 | 31.05 | | O |
| ANISOU | 3169 | O | ASN | A | 465 | 2649 | 3766 | 5383 | 288 | 616 | −58 | O |
| ATOM | 3170 | CB | ASN | A | 465 | 23.899 | 99.283 | 45.200 | 1.00 | 30.74 | | C |
| ANISOU | 3170 | CB | ASN | A | 465 | 2232 | 3669 | 5777 | 225 | 384 | −44 | C |
| ATOM | 3171 | CG | ASN | A | 465 | 24.550 | 100.112 | 46.268 | 1.00 | 41.88 | | C |
| ANISOU | 3171 | CG | ASN | A | 465 | 3455 | 5039 | 7418 | 212 | 127 | −42 | C |
| ATOM | 3172 | OD1 | ASN | A | 465 | 25.516 | 99.684 | 46.897 | 1.00 | 53.82 | | O |
| ANISOU | 3172 | OD1 | ASN | A | 465 | 4733 | 6439 | 9277 | 274 | −44 | −81 | O |
| ATOM | 3173 | ND2 | ASN | A | 465 | 23.990 | 101.284 | 46.524 | 1.00 | 30.26 | | N |
| ANISOU | 3173 | ND2 | ASN | A | 465 | 2095 | 3646 | 5756 | 139 | 64 | 0 | N |
| ATOM | 3174 | N | CYS | A | 466 | 20.554 | 98.395 | 44.098 | 1.00 | 27.80 | | N |
| ANISOU | 3174 | N | CYS | A | 466 | 2582 | 3546 | 4436 | 197 | 468 | 34 | N |
| ATOM | 3175 | CA | CYS | A | 466 | 19.844 | 97.598 | 43.103 | 1.00 | 30.49 | | C |
| ANISOU | 3175 | CA | CYS | A | 466 | 3117 | 3897 | 4570 | 208 | 615 | 9 | C |
| ATOM | 3176 | C | CYS | A | 466 | 20.323 | 97.946 | 41.704 | 1.00 | 32.52 | | C |
| ANISOU | 3176 | C | CYS | A | 466 | 3432 | 4099 | 4824 | 174 | 941 | −34 | C |
| ATOM | 3177 | O | CYS | A | 466 | 20.790 | 99.051 | 41.461 | 1.00 | 37.11 | | O |
| ANISOU | 3177 | O | CYS | A | 466 | 3966 | 4667 | 5469 | 119 | 1051 | −21 | O |
| ATOM | 3178 | CB | CYS | A | 466 | 18.323 | 97.808 | 43.211 | 1.00 | 25.22 | | C |
| ANISOU | 3178 | CB | CYS | A | 466 | 2672 | 3331 | 3578 | 175 | 485 | 51 | C |
| ATOM | 3179 | SG | CYS | A | 466 | 17.600 | 97.339 | 44.815 | 1.00 | 39.40 | | S |
| ANISOU | 3179 | SG | CYS | A | 466 | 4465 | 5171 | 5332 | 201 | 179 | 102 | S |
| ATOM | 3180 | N | PRO | A | 467 | 20.246 | 96.983 | 40.779 | 1.00 | 35.50 | | N |
| ANISOU | 3180 | N | PRO | A | 467 | 3932 | 4428 | 5129 | 206 | 1111 | −89 | N |
| ATOM | 3181 | CA | PRO | A | 467 | 20.549 | 97.284 | 39.369 | 1.00 | 29.54 | | C |
| ANISOU | 3181 | CA | PRO | A | 467 | 3330 | 3609 | 4285 | 171 | 1443 | −130 | C |
| ATOM | 3182 | C | PRO | A | 467 | 19.540 | 98.286 | 38.788 | 1.00 | 32.57 | | C |
| ANISOU | 3182 | C | PRO | A | 467 | 3988 | 4059 | 4327 | 106 | 1423 | −81 | C |
| ATOM | 3183 | O | PRO | A | 467 | 18.424 | 98.390 | 39.305 | 1.00 | 33.60 | | O |
| ANISOU | 3183 | O | PRO | A | 467 | 4201 | 4282 | 4282 | 102 | 1166 | −41 | O |
| ATOM | 3184 | CB | PRO | A | 467 | 20.425 | 95.925 | 38.681 | 1.00 | 30.35 | | C |
| ANISOU | 3184 | CB | PRO | A | 467 | 3557 | 3651 | 4323 | 227 | 1553 | −204 | C |
| ATOM | 3185 | CG | PRO | A | 467 | 20.545 | 94.894 | 39.810 | 1.00 | 35.27 | | C |
| ANISOU | 3185 | CG | PRO | A | 467 | 3978 | 4273 | 5150 | 299 | 1323 | −205 | C |
| ATOM | 3186 | CD | PRO | A | 467 | 19.936 | 95.559 | 41.006 | 1.00 | 33.07 | | C |
| ANISOU | 3186 | CD | PRO | A | 467 | 3645 | 4100 | 4820 | 274 | 1017 | −119 | C |
| ATOM | 3187 | N | SER | A | 468 | 19.931 | 99.013 | 37.747 | 1.00 | 33.85 | | N |
| ANISOU | 3187 | N | SER | A | 468 | 4290 | 4156 | 4413 | 57 | 1696 | −85 | N |
| ATOM | 3188 | CA | SER | A | 468 | 19.045 | 99.960 | 37.069 | 1.00 | 32.99 | | C |
| ANISOU | 3188 | CA | SER | A | 468 | 4479 | 4078 | 3977 | 5 | 1676 | −36 | C |
| ATOM | 3189 | C | SER | A | 468 | 18.834 | 99.620 | 35.605 | 1.00 | 37.57 | | C |
| ANISOU | 3189 | C | SER | A | 468 | 5420 | 4574 | 4282 | 4 | 1896 | −79 | C |
| ATOM | 3190 | O | SER | A | 468 | 19.766 | 99.226 | 34.911 | 1.00 | 36.39 | | O |
| ANISOU | 3190 | O | SER | A | 468 | 5289 | 4315 | 4224 | 7 | 2224 | −136 | O |
| ATOM | 3191 | CB | SER | A | 468 | 19.590 | 101.388 | 37.161 | 1.00 | 30.19 | | C |
| ANISOU | 3191 | CB | SER | A | 468 | 4049 | 3705 | 3719 | −65 | 1771 | 22 | C |
| ATOM | 3192 | OG | SER | A | 468 | 19.427 | 101.897 | 38.461 | 1.00 | 42.01 | | O |
| ANISOU | 3192 | OG | SER | A | 468 | 5316 | 5287 | 5359 | −69 | 1498 | 65 | O |
| ATOM | 3193 | N | HIS | A | 469 | 17.608 | 99.813 | 35.129 | 1.00 | 38.04 | | N |
| ANISOU | 3193 | N | HIS | A | 469 | 5775 | 4668 | 4009 | 0 | 1715 | −58 | N |
| ATOM | 3194 | CA | HIS | A | 469 | 17.317 | 99.687 | 33.705 | 1.00 | 38.05 | | C |
| ANISOU | 3194 | CA | HIS | A | 469 | 6194 | 4575 | 3688 | −3 | 1868 | −91 | C |
| ATOM | 3195 | C | HIS | A | 469 | 16.302 | 100.749 | 33.347 | 1.00 | 45.00 | | C |
| ANISOU | 3195 | C | HIS | A | 469 | 7334 | 5474 | 4289 | −34 | 1672 | −22 | C |
| ATOM | 3196 | O | HIS | A | 469 | 15.290 | 100.874 | 34.026 | 1.00 | 50.18 | | O |
| ANISOU | 3196 | O | HIS | A | 469 | 7908 | 6223 | 4934 | −20 | 1337 | 2 | O |
| ATOM | 3197 | CB | HIS | A | 469 | 16.789 | 98.296 | 33.372 | 1.00 | 33.54 | | C |
| ANISOU | 3197 | CB | HIS | A | 469 | 5744 | 3987 | 3011 | 55 | 1782 | −180 | C |
| ATOM | 3198 | CG | HIS | A | 469 | 17.613 | 97.189 | 33.943 | 1.00 | 33.96 | | C |
| ANISOU | 3198 | CG | HIS | A | 469 | 5506 | 4029 | 3369 | 99 | 1889 | −241 | C |
| ATOM | 3199 | ND1 | HIS | A | 469 | 18.700 | 96.655 | 33.284 | 1.00 | 36.80 | | N |
| ANISOU | 3199 | ND1 | HIS | A | 469 | 5883 | 4270 | 3831 | 114 | 2254 | −313 | N |
| ATOM | 3200 | CD2 | HIS | A | 469 | 17.523 | 96.527 | 35.120 | 1.00 | 35.24 | | C |
| ANISOU | 3200 | CD2 | HIS | A | 469 | 5361 | 4264 | 3764 | 136 | 1680 | −240 | C |
| ATOM | 3201 | CE1 | HIS | A | 469 | 19.234 | 95.702 | 34.025 | 1.00 | 37.62 | | C |
| ANISOU | 3201 | CE1 | HIS | A | 469 | 5680 | 4374 | 4238 | 166 | 2237 | −357 | C |
| ATOM | 3202 | NE2 | HIS | A | 469 | 18.539 | 95.605 | 35.144 | 1.00 | 38.10 | | N |
| ANISOU | 3202 | NE2 | HIS | A | 469 | 5561 | 4551 | 4366 | 180 | 1884 | −307 | N |
| ATOM | 3203 | N | PRO | A | 470 | 16.584 | 101.547 | 32.307 | 1.00 | 54.84 | | N |
| ANISOU | 3203 | N | PRO | A | 470 | 8893 | 6617 | 5329 | −74 | 1891 | 11 | N |
| ATOM | 3204 | CA | PRO | A | 470 | 17.817 | 101.487 | 31.522 | 1.00 | 65.34 | | C |
| ANISOU | 3204 | CA | PRO | A | 470 | 10299 | 7815 | 6711 | −102 | 2328 | −17 | C |
| ATOM | 3205 | C | PRO | A | 470 | 18.987 | 102.165 | 32.225 | 1.00 | 65.55 | | C |
| ANISOU | 3205 | C | PRO | A | 470 | 9971 | 7838 | 7095 | −153 | 2564 | 19 | C |
| ATOM | 3206 | O | PRO | A | 470 | 20.105 | 101.683 | 32.042 | 1.00 | 73.16 | | O |
| ANISOU | 3206 | O | PRO | A | 470 | 10773 | 8718 | 8307 | −154 | 2845 | −39 | O |
| ATOM | 3207 | CB | PRO | A | 470 | 17.446 | 102.245 | 30.242 | 1.00 | 67.65 | | C |
| ANISOU | 3207 | CB | PRO | A | 470 | 10993 | 7990 | 6719 | −128 | 2296 | 23 | C |
| ATOM | 3208 | CG | PRO | A | 470 | 15.934 | 102.384 | 30.276 | 1.00 | 58.17 | | C |
| ANISOU | 3208 | CG | PRO | A | 470 | 9974 | 6856 | 5271 | −94 | 1867 | 46 | C |
| ATOM | 3209 | CD | PRO | A | 470 | 15.631 | 102.498 | 31.717 | 1.00 | 53.29 | | C |
| ANISOU | 3209 | CD | PRO | A | 470 | 9032 | 6394 | 4822 | −90 | 1706 | 75 | C |
| TER | | | | | | | | | | | | |
| ATOM | 3210 | O | LYS | B | 44 | −5.621 | 65.122 | 47.879 | 1.00 | 68.77 | | O |
| ANISOU | 3210 | O | LYS | B | 44 | 10210 | 9329 | 6592 | 2441 | −408 | −1623 | O |
| ATOM | 3211 | N | LYS | B | 44 | −3.834 | 62.335 | 49.408 | 1.00 | 66.56 | | N |
| ANISOU | 3211 | N | LYS | B | 44 | 10065 | 9200 | 6025 | 2713 | −759 | −1578 | N |
| ATOM | 3212 | CA | LYS | B | 44 | −4.696 | 63.518 | 49.409 | 1.00 | 71.74 | | C |
| ANISOU | 3212 | CA | LYS | B | 44 | 10790 | 9790 | 6679 | 2723 | −626 | −1591 | C |
| ATOM | 3213 | C | LYS | B | 44 | −4.887 | 64.146 | 48.021 | 1.00 | 70.70 | | C |
| ANISOU | 3213 | C | LYS | B | 44 | 10422 | 9635 | 6807 | 2442 | −545 | −1624 | C |
| ATOM | 3214 | CB | LYS | B | 44 | −4.128 | 64.579 | 50.357 | 1.00 | 73.49 | | C |
| ANISOU | 3214 | CB | LYS | B | 44 | 11171 | 9922 | 6829 | 2876 | −867 | −1848 | C |
| ATOM | 3215 | CG | LYS | B | 44 | −5.132 | 65.621 | 50.860 | 1.00 | 75.91 | | C |
| ANISOU | 3215 | CG | LYS | B | 44 | 11668 | 10155 | 7020 | 3010 | −705 | −1821 | C |
| ATOM | 3216 | CD | LYS | B | 44 | −4.418 | 66.680 | 51.701 | 1.00 | 77.99 | | C |
| ANISOU | 3216 | CD | LYS | B | 44 | 12073 | 10320 | 7241 | 3133 | −988 | −2120 | C |
| ATOM | 3217 | CE | LYS | B | 44 | −5.348 | 67.808 | 52.154 | 1.00 | 81.93 | | C |
| ANISOU | 3217 | CE | LYS | B | 44 | 12765 | 10727 | 7636 | 3256 | −833 | −2116 | C |
| ATOM | 3218 | NZ | LYS | B | 44 | −6.445 | 67.390 | 53.079 | 1.00 | 86.01 | | N |
| ANISOU | 3218 | NZ | LYS | B | 44 | 13551 | 11272 | 7855 | 3554 | −586 | −1852 | N |
| ATOM | 3219 | O | ASP | B | 45 | −6.459 | 62.861 | 45.344 | 1.00 | 58.72 | | O |
| ANISOU | 3219 | O | ASP | B | 45 | 8484 | 8271 | 5557 | 2067 | −49 | −1175 | O |
| ATOM | 3220 | N | ASP | B | 45 | −4.261 | 63.568 | 47.000 | 1.00 | 69.15 | | N |
| ANISOU | 3220 | N | ASP | B | 45 | 10000 | 9482 | 6793 | 2231 | −610 | −1637 | N |
| ATOM | 3221 | CA | ASP | B | 45 | −4.391 | 64.067 | 45.622 | 1.00 | 65.87 | | C |
| ANISOU | 3221 | CA | ASP | B | 45 | 9370 | 9041 | 6617 | 1995 | −531 | −1657 | C |
| ATOM | 3222 | C | ASP | B | 45 | −5.769 | 63.820 | 45.002 | 1.00 | 53.09 | | C |
| ANISOU | 3222 | C | ASP | B | 45 | 7712 | 7481 | 4978 | 1978 | −209 | −1398 | C |
| ATOM | 3223 | CB | ASP | B | 45 | −3.318 | 63.448 | 44.716 | 1.00 | 71.25 | | C |
| ANISOU | 3223 | CB | ASP | B | 45 | 9832 | 9750 | 7491 | 1799 | −683 | −1728 | C |
| ATOM | 3224 | CG | ASP | B | 45 | −1.924 | 64.030 | 44.960 | 1.00 | 76.21 | | C |
| ANISOU | 3224 | CG | ASP | B | 45 | 10387 | 10283 | 8286 | 1751 | −983 | −2007 | C |
| ATOM | 3225 | OD1 | ASP | B | 45 | −1.821 | 65.156 | 45.508 | 1.00 | 76.82 | | O |
| ANISOU | 3225 | OD1 | ASP | B | 45 | 10544 | 10253 | 8393 | 1808 | −1071 | −2181 | O |
| ATOM | 3226 | OD2 | ASP | B | 45 | −0.934 | 63.353 | 44.600 | 1.00 | 71.73 | | O |
| ANISOU | 3226 | OD2 | ASP | B | 45 | 9670 | 9741 | 7842 | 1657 | −1121 | −2047 | O |
| ATOM | 3227 | N | LEU | B | 46 | −6.173 | 64.703 | 44.100 | 1.00 | 38.46 | | N |
| ANISOU | 3227 | N | LEU | B | 46 | 5746 | 5577 | 3289 | 1873 | −106 | −1421 | N |
| ATOM | 3228 | CA | LEU | B | 46 | −7.394 | 64.500 | 43.337 | 1.00 | 35.89 | | C |
| ANISOU | 3228 | CA | LEU | B | 46 | 5315 | 5316 | 3004 | 1845 | 171 | −1179 | C |
| ATOM | 3229 | C | LEU | B | 46 | −7.166 | 63.396 | 42.287 | 1.00 | 37.94 | | C |
| ANISOU | 3229 | C | LEU | B | 46 | 5381 | 5683 | 3352 | 1690 | 169 | −1084 | C |
| ATOM | 3230 | O | LEU | B | 46 | −6.231 | 63.474 | 41.493 | 1.00 | 34.25 | | O |
| ANISOU | 3230 | O | LEU | B | 46 | 4786 | 5192 | 3035 | 1540 | 18 | −1227 | O |
| ATOM | 3231 | CB | LEU | B | 46 | −7.824 | 65.801 | 42.671 | 1.00 | 36.68 | | C |
| ANISOU | 3231 | CB | LEU | B | 46 | 5350 | 5325 | 3263 | 1809 | 273 | −1225 | C |
| ATOM | 3232 | CG | LEU | B | 46 | −9.173 | 65.817 | 41.949 | 1.00 | 39.26 | | C |
| ANISOU | 3232 | CG | LEU | B | 46 | 5546 | 5710 | 3662 | 1811 | 547 | −961 | C |
| ATOM | 3233 | CD1 | LEU | B | 46 | −10.285 | 65.366 | 42.881 | 1.00 | 37.28 | | C |
| ANISOU | 3233 | CD1 | LEU | B | 46 | 5396 | 5502 | 3266 | 1959 | 734 | −740 | C |
| ATOM | 3234 | CD2 | LEU | B | 46 | −9.480 | 67.204 | 41.388 | 1.00 | 32.73 | | C |
| ANISOU | 3234 | CD2 | LEU | B | 46 | 4681 | 4768 | 2987 | 1805 | 631 | −1010 | C |
| ATOM | 3235 | N | LEU | B | 47 | −8.000 | 62.360 | 42.310 | 1.00 | 38.17 | | N |
| ANISOU | 3235 | N | LEU | B | 47 | 5381 | 5807 | 3315 | 1717 | 342 | −839 | N |
| ATOM | 3236 | CA | LEU | B | 47 | −7.870 | 61.224 | 41.391 | 1.00 | 30.48 | | C |
| ANISOU | 3236 | CA | LEU | B | 47 | 4233 | 4920 | 2427 | 1559 | 339 | −726 | C |
| ATOM | 3237 | C | LEU | B | 47 | −9.115 | 61.032 | 40.514 | 1.00 | 35.21 | | C |
| ANISOU | 3237 | C | LEU | B | 47 | 4632 | 5546 | 3199 | 1451 | 533 | −474 | C |
| ATOM | 3238 | O | LEU | B | 47 | −10.216 | 60.907 | 41.044 | 1.00 | 35.36 | | O |
| ANISOU | 3238 | O | LEU | B | 47 | 4677 | 5588 | 3172 | 1578 | 748 | −309 | O |
| ATOM | 3239 | CB | LEU | B | 47 | −7.619 | 59.938 | 42.180 | 1.00 | 27.64 | | C |
| ANISOU | 3239 | CB | LEU | B | 47 | 3988 | 4606 | 1907 | 1636 | 325 | −653 | C |
| ATOM | 3240 | CG | LEU | B | 47 | −6.426 | 59.862 | 43.130 | 1.00 | 35.63 | | C |
| ANISOU | 3240 | CG | LEU | B | 47 | 5159 | 5570 | 2807 | 1717 | 90 | −830 | C |
| ATOM | 3241 | CD1 | LEU | B | 47 | −6.408 | 58.511 | 43.820 | 1.00 | 33.78 | | C |
| ANISOU | 3241 | CD1 | LEU | B | 47 | 5022 | 5366 | 2446 | 1805 | 136 | −685 | C |
| ATOM | 3242 | CD2 | LEU | B | 47 | −5.117 | 60.094 | 42.376 | 1.00 | 30.52 | | C |
| ANISOU | 3242 | CD2 | LEU | B | 47 | 4387 | 4907 | 2304 | 1558 | −157 | −1043 | C |
| ATOM | 3243 | N | TYR | B | 48 | −8.958 | 60.998 | 39.191 | 1.00 | 24.38 | | N |
| ANISOU | 3243 | N | TYR | B | 48 | 3064 | 4166 | 2033 | 1240 | 458 | −444 | N |
| ATOM | 3244 | CA | TYR | B | 48 | −10.071 | 60.598 | 38.327 | 1.00 | 31.03 | | C |
| ANISOU | 3244 | CA | TYR | B | 48 | 3712 | 5047 | 3030 | 1147 | 570 | −232 | C |
| ATOM | 3245 | C | TYR | B | 48 | −9.877 | 59.150 | 37.902 | 1.00 | 27.17 | | C |
| ANISOU | 3245 | C | TYR | B | 48 | 3144 | 4605 | 2573 | 1021 | 516 | −151 | C |
| ATOM | 3246 | O | TYR | B | 48 | −8.862 | 58.816 | 37.315 | 1.00 | 27.39 | | O |
| ANISOU | 3246 | O | TYR | B | 48 | 3167 | 4623 | 2617 | 908 | 358 | −243 | O |
| ATOM | 3247 | CB | TYR | B | 48 | −10.191 | 61.479 | 37.077 | 1.00 | 27.95 | | C |
| ANISOU | 3247 | CB | TYR | B | 48 | 3191 | 4618 | 2813 | 1044 | 526 | −235 | C |
| ATOM | 3248 | CG | TYR | B | 48 | −10.639 | 62.889 | 37.330 | 1.00 | 26.44 | | C |
| ANISOU | 3248 | CG | TYR | B | 48 | 3050 | 4365 | 2631 | 1162 | 622 | −268 | C |
| ATOM | 3249 | CD1 | TYR | B | 48 | −11.000 | 63.313 | 38.602 | 1.00 | 25.67 | | C |
| ANISOU | 3249 | CD1 | TYR | B | 48 | 3106 | 4255 | 2392 | 1351 | 740 | −294 | C |
| ATOM | 3250 | CD2 | TYR | B | 48 | −10.716 | 63.803 | 36.287 | 1.00 | 28.35 | | C |
| ANISOU | 3250 | CD2 | TYR | B | 48 | 3213 | 4551 | 3007 | 1113 | 613 | −265 | C |
| ATOM | 3251 | CE1 | TYR | B | 48 | −11.414 | 64.621 | 38.829 | 1.00 | 29.01 | | C |
| ANISOU | 3251 | CE1 | TYR | B | 48 | 3594 | 4606 | 2821 | 1470 | 835 | −331 | C |
| ATOM | 3252 | CE2 | TYR | B | 48 | −11.132 | 65.112 | 36.505 | 1.00 | 29.25 | | C |
| ANISOU | 3252 | CE2 | TYR | B | 48 | 3384 | 4592 | 3138 | 1230 | 719 | −289 | C |
| ATOM | 3253 | CZ | TYR | B | 48 | −11.479 | 65.513 | 37.771 | 1.00 | 31.74 | | C |
| ANISOU | 3253 | CZ | TYR | B | 48 | 3842 | 4892 | 3327 | 1398 | 825 | −327 | C |
| ATOM | 3254 | OH | TYR | B | 48 | −11.892 | 66.806 | 37.973 | 1.00 | 36.98 | | O |
| ANISOU | 3254 | OH | TYR | B | 48 | 4579 | 5469 | 4004 | 1521 | 937 | −355 | O |
| ATOM | 3255 | N | LYS | B | 49 | −10.869 | 58.310 | 38.175 | 1.00 | 27.31 | | N |
| ANISOU | 3255 | N | LYS | B | 49 | 3094 | 4654 | 2629 | 1040 | 668 | 26 | N |
| ATOM | 3256 | CA | LYS | B | 49 | −10.773 | 56.878 | 37.930 | 1.00 | 27.15 | | C |
| ANISOU | 3256 | CA | LYS | B | 49 | 3018 | 4650 | 2650 | 934 | 649 | 105 | C |
| ATOM | 3257 | C | LYS | B | 49 | −11.686 | 56.446 | 36.793 | 1.00 | 33.13 | | C |
| ANISOU | 3257 | C | LYS | B | 49 | 3533 | 5409 | 3647 | 777 | 637 | 223 | C |
| ATOM | 3258 | O | LYS | B | 49 | −12.857 | 56.833 | 36.759 | 1.00 | 36.82 | | O |
| ANISOU | 3258 | O | LYS | B | 49 | 3860 | 5879 | 4250 | 810 | 756 | 332 | O |
| ATOM | 3259 | CB | LYS | B | 49 | −11.129 | 56.098 | 39.199 | 1.00 | 25.62 | | C |
| ANISOU | 3259 | CB | LYS | B | 49 | 2945 | 4452 | 2337 | 1085 | 848 | 215 | C |
| ATOM | 3260 | CG | LYS | B | 49 | −10.084 | 56.205 | 40.299 | 1.00 | 33.09 | | C |
| ANISOU | 3260 | CG | LYS | B | 49 | 4166 | 5408 | 3000 | 1264 | 796 | 78 | C |
| ATOM | 3261 | CD | LYS | B | 49 | −10.556 | 55.613 | 41.622 | 1.00 | 31.82 | | C |
| ANISOU | 3261 | CD | LYS | B | 49 | 4182 | 5237 | 2669 | 1492 | 1037 | 208 | C |
| ATOM | 3262 | CE | LYS | B | 49 | −9.415 | 55.551 | 42.634 | 1.00 | 38.72 | | C |
| ANISOU | 3262 | CE | LYS | B | 49 | 5330 | 6083 | 3298 | 1639 | 873 | 58 | C |
| ATOM | 3263 | NZ | LYS | B | 49 | −9.763 | 54.726 | 43.833 | 1.00 | 47.97 | | N |
| ANISOU | 3263 | NZ | LYS | B | 49 | 6679 | 7176 | 4372 | 1806 | 1037 | 211 | N |
| ATOM | 3264 | N | TYR | B | 50 | −11.138 | 55.653 | 35.873 | 1.00 | 23.97 | | N |
| ANISOU | 3264 | N | TYR | B | 50 | 2326 | 4244 | 2537 | 623 | 480 | 189 | N |
| ATOM | 3265 | CA | TYR | B | 50 | −11.875 | 55.124 | 34.716 | 1.00 | 26.37 | | C |
| ANISOU | 3265 | CA | TYR | B | 50 | 2431 | 4543 | 3046 | 480 | 401 | 255 | C |
| ATOM | 3266 | C | TYR | B | 50 | −11.810 | 53.603 | 34.716 | 1.00 | 24.27 | | C |
| ANISOU | 3266 | C | TYR | B | 50 | 2146 | 4242 | 2835 | 379 | 402 | 305 | C |
| ATOM | 3267 | O | TYR | B | 50 | −10.763 | 53.049 | 34.987 | 1.00 | 29.17 | | O |
| ANISOU | 3267 | O | TYR | B | 50 | 2919 | 4853 | 3310 | 380 | 364 | 247 | O |
| ATOM | 3268 | CB | TYR | B | 50 | −11.305 | 55.686 | 33.416 | 1.00 | 22.84 | | C |
| ANISOU | 3268 | CB | TYR | B | 50 | 1984 | 4100 | 2596 | 416 | 207 | 158 | C |
| ATOM | 3269 | CG | TYR | B | 50 | −11.141 | 57.188 | 33.471 | 1.00 | 29.08 | | C |
| ANISOU | 3269 | CG | TYR | B | 50 | 2829 | 4890 | 3330 | 518 | 233 | 102 | C |
| ATOM | 3270 | CD1 | TYR | B | 50 | −12.208 | 58.040 | 33.182 | 1.00 | 34.84 | | C |
| ANISOU | 3270 | CD1 | TYR | B | 50 | 3441 | 5636 | 4160 | 578 | 282 | 167 | C |
| ATOM | 3271 | CD2 | TYR | B | 50 | −9.934 | 57.760 | 33.863 | 1.00 | 28.68 | | C |
| ANISOU | 3271 | CD2 | TYR | B | 50 | 2935 | 4808 | 3153 | 558 | 212 | −23 | C |
| ATOM | 3272 | CE1 | TYR | B | 50 | −12.062 | 59.422 | 33.256 | 1.00 | 38.13 | | C |
| ANISOU | 3272 | CE1 | TYR | B | 50 | 3928 | 6030 | 4532 | 679 | 330 | 121 | C |
| ATOM | 3273 | CE2 | TYR | B | 50 | −9.778 | 59.137 | 33.939 | 1.00 | 24.58 | | C |
| ANISOU | 3273 | CE2 | TYR | B | 50 | 2464 | 4253 | 2624 | 638 | 245 | −89 | C |
| ATOM | 3274 | CZ | TYR | B | 50 | −10.845 | 59.961 | 33.639 | 1.00 | 33.28 | | C |
| ANISOU | 3274 | CZ | TYR | B | 50 | 3478 | 5363 | 3805 | 700 | 317 | −11 | C |
| ATOM | 3275 | OH | TYR | B | 50 | −10.697 | 61.323 | 33.715 | 1.00 | 31.62 | | O |
| ANISOU | 3275 | OH | TYR | B | 50 | 3330 | 5095 | 3589 | 785 | 371 | −71 | O |
| ATOM | 3276 | N | LYS | B | 51 | −12.930 | 52.939 | 34.444 | 1.00 | 27.83 | | N |
| ANISOU | 3276 | N | LYS | B | 51 | 2398 | 4660 | 3518 | 298 | 448 | 408 | N |
| ATOM | 3277 | CA | LYS | B | 51 | −12.994 | 51.473 | 34.373 | 1.00 | 32.38 | | C |
| ANISOU | 3277 | CA | LYS | B | 51 | 2933 | 5163 | 4206 | 181 | 460 | 454 | C |
| ATOM | 3278 | C | LYS | B | 51 | −12.276 | 50.898 | 33.152 | 1.00 | 28.85 | | C |
| ANISOU | 3278 | C | LYS | B | 51 | 2523 | 4701 | 3738 | 52 | 212 | 344 | C |
| ATOM | 3279 | O | LYS | B | 51 | −12.410 | 51.415 | 32.055 | 1.00 | 27.04 | | O |
| ANISOU | 3279 | O | LYS | B | 51 | 2230 | 4500 | 3544 | 16 | 27 | 276 | O |
| ATOM | 3280 | CB | LYS | B | 51 | −14.448 | 50.994 | 34.343 | 1.00 | 42.34 | | C |
| ANISOU | 3280 | CB | LYS | B | 51 | 3921 | 6363 | 5803 | 109 | 565 | 574 | C |
| ATOM | 3281 | CG | LYS | B | 51 | −15.208 | 51.162 | 35.639 | 1.00 | 53.51 | | C |
| ANISOU | 3281 | CG | LYS | B | 51 | 5302 | 7750 | 7278 | 241 | 894 | 734 | C |
| ATOM | 3282 | CD | LYS | B | 51 | −16.635 | 50.614 | 35.524 | 1.00 | 58.25 | | C |
| ANISOU | 3282 | CD | LYS | B | 51 | 5574 | 8262 | 8298 | 145 | 1012 | 859 | C |
| ATOM | 3283 | CE | LYS | B | 51 | −17.464 | 50.990 | 36.747 | 1.00 | 59.92 | | C |
| ANISOU | 3283 | CE | LYS | B | 51 | 5743 | 8444 | 8581 | 311 | 1382 | 1043 | C |
| ATOM | 3284 | NZ | LYS | B | 51 | −18.793 | 50.321 | 36.779 | 1.00 | 67.09 | | N |
| ANISOU | 3284 | NZ | LYS | B | 51 | 6348 | 9215 | 9927 | 211 | 1531 | 1166 | N |
| ATOM | 3285 | N | LEU | B | 52 | −11.477 | 49.856 | 33.350 | 1.00 | 25.89 | | N |
| ANISOU | 3285 | N | LEU | B | 52 | 2281 | 4280 | 3277 | 15 | 220 | 333 | N |
| ATOM | 3286 | CA | LEU | B | 52 | −10.958 | 49.092 | 32.214 | 1.00 | 24.79 | | C |
| ANISOU | 3286 | CA | LEU | B | 52 | 2174 | 4098 | 3145 | −104 | 20 | 251 | C |
| ATOM | 3287 | C | LEU | B | 52 | −11.593 | 47.690 | 32.136 | 1.00 | 31.01 | | C |
| ANISOU | 3287 | C | LEU | B | 52 | 2862 | 4768 | 4152 | −233 | 54 | 304 | C |
| ATOM | 3288 | O | LEU | B | 52 | −11.892 | 47.070 | 33.154 | 1.00 | 24.32 | | O |
| ANISOU | 3288 | O | LEU | B | 52 | 2009 | 3860 | 3373 | −212 | 279 | 416 | O |
| ATOM | 3289 | CB | LEU | B | 52 | −9.450 | 48.953 | 32.298 | 1.00 | 26.18 | | C |
| ANISOU | 3289 | CB | LEU | B | 52 | 2574 | 4294 | 3081 | −54 | −20 | 181 | C |
| ATOM | 3290 | CG | LEU | B | 52 | −8.628 | 50.208 | 32.489 | 1.00 | 27.26 | | C |
| ANISOU | 3290 | CG | LEU | B | 52 | 2803 | 4507 | 3048 | 55 | −43 | 110 | C |
| ATOM | 3291 | CD1 | LEU | B | 52 | −7.187 | 49.780 | 32.703 | 1.00 | 17.67 | | C |
| ANISOU | 3291 | CD1 | LEU | B | 52 | 1755 | 3290 | 1668 | 91 | −74 | 49 | C |
| ATOM | 3292 | CD2 | LEU | B | 52 | −8.785 | 51.105 | 31.282 | 1.00 | 18.16 | | C |
| ANISOU | 3292 | CD2 | LEU | B | 52 | 1594 | 3372 | 1933 | 34 | −181 | 55 | C |
| ATOM | 3293 | N | TYR | B | 53 | −11.807 | 47.205 | 30.922 | 1.00 | 29.86 | | N |
| ANISOU | 3293 | N | TYR | B | 53 | 2652 | 4573 | 4119 | −351 | −163 | 220 | N |
| ATOM | 3294 | CA | TYR | B | 53 | −12.253 | 45.838 | 30.728 | 1.00 | 32.43 | | C |
| ANISOU | 3294 | CA | TYR | B | 53 | 2900 | 4756 | 4664 | −492 | −171 | 228 | C |
| ATOM | 3295 | C | TYR | B | 53 | −11.203 | 45.085 | 29.932 | 1.00 | 35.21 | | C |
| ANISOU | 3295 | C | TYR | B | 53 | 3458 | 5064 | 4856 | −527 | −326 | 129 | C |
| ATOM | 3296 | O | TYR | B | 53 | −10.422 | 45.698 | 29.192 | 1.00 | 31.48 | | O |
| ANISOU | 3296 | O | TYR | B | 53 | 3121 | 4668 | 4170 | −461 | −473 | 47 | O |
| ATOM | 3297 | CB | TYR | B | 53 | −13.611 | 45.780 | 30.013 | 1.00 | 33.87 | | C |
| ANISOU | 3297 | CB | TYR | B | 53 | 2797 | 4888 | 5183 | −603 | −320 | 190 | C |
| ATOM | 3298 | CG | TYR | B | 53 | −14.698 | 46.585 | 30.672 | 1.00 | 37.07 | | C |
| ANISOU | 3298 | CG | TYR | B | 53 | 2971 | 5339 | 5776 | −556 | −169 | 294 | C |
| ATOM | 3299 | CD1 | TYR | B | 53 | −14.849 | 47.942 | 30.420 | 1.00 | 41.60 | | C |
| ANISOU | 3299 | CD1 | TYR | B | 53 | 3521 | 6048 | 6235 | −443 | −244 | 274 | C |
| ATOM | 3300 | CD2 | TYR | B | 53 | −15.573 | 45.983 | 31.559 | 1.00 | 47.98 | | C |
| ANISOU | 3300 | CD2 | TYR | B | 53 | 4164 | 6608 | 7460 | −611 | 86 | 428 | C |
| ATOM | 3301 | CE1 | TYR | B | 53 | −15.849 | 48.677 | 31.043 | 1.00 | 51.97 | | C |
| ANISOU | 3301 | CE1 | TYR | B | 53 | 4631 | 7397 | 7717 | −382 | −86 | 378 | C |
| ATOM | 3302 | CE2 | TYR | B | 53 | −16.576 | 46.704 | 32.182 | 1.00 | 57.51 | | C |
| ANISOU | 3302 | CE2 | TYR | B | 53 | 5158 | 7845 | 8849 | −548 | 264 | 543 | C |
| ATOM | 3303 | CZ | TYR | B | 53 | −16.712 | 48.046 | 31.925 | 1.00 | 60.60 | | C |
| ANISOU | 3303 | CZ | TYR | B | 53 | 5532 | 8385 | 9108 | −432 | 168 | 513 | C |
| ATOM | 3304 | OH | TYR | B | 53 | −17.720 | 48.739 | 32.558 | 1.00 | 69.84 | | O |
| ANISOU | 3304 | OH | TYR | B | 53 | 6498 | 9578 | 10461 | −355 | 362 | 636 | O |
| ATOM | 3305 | N | GLY | B | 54 | −11.182 | 43.760 | 30.090 | 1.00 | 34.88 | | N |
| ANISOU | 3305 | N | GLY | B | 54 | 3444 | 4880 | 4927 | −620 | −261 | 150 | N |
| ATOM | 3306 | CA | GLY | B | 54 | −10.297 | 42.916 | 29.308 | 1.00 | 31.16 | | C |
| ANISOU | 3306 | CA | GLY | B | 54 | 3167 | 4342 | 4332 | −654 | −397 | 60 | C |
| ATOM | 3307 | C | GLY | B | 54 | −9.593 | 41.819 | 30.084 | 1.00 | 30.11 | | C |
| ANISOU | 3307 | C | GLY | B | 54 | 3190 | 4115 | 4136 | −642 | −200 | 140 | C |
| ATOM | 3308 | O | GLY | B | 54 | −9.852 | 41.614 | 31.269 | 1.00 | 28.36 | | O |
| ANISOU | 3308 | O | GLY | B | 54 | 2937 | 3868 | 3972 | −602 | 56 | 274 | O |
| ATOM | 3309 | N | ASP | B | 55 | −8.722 | 41.100 | 29.380 | 1.00 | 27.96 | | N |
| ANISOU | 3309 | N | ASP | B | 55 | 3106 | 3785 | 3734 | −651 | −308 | 65 | N |
| ATOM | 3310 | CA | ASP | B | 55 | −7.903 | 40.039 | 29.952 | 1.00 | 34.29 | | C |
| ANISOU | 3310 | CA | ASP | B | 55 | 4088 | 4501 | 4440 | −615 | −148 | 131 | C |
| ATOM | 3311 | C | ASP | B | 55 | −6.863 | 39.650 | 28.935 | 1.00 | 30.96 | | C |
| ANISOU | 3311 | C | ASP | B | 55 | 3871 | 4059 | 3833 | −590 | −309 | 31 | C |
| ATOM | 3312 | O | ASP | B | 55 | −6.911 | 40.089 | 27.786 | 1.00 | 26.90 | | O |
| ANISOU | 3312 | O | ASP | B | 55 | 3367 | 3572 | 3284 | −606 | −529 | −84 | O |
| ATOM | 3313 | CB | ASP | B | 55 | −8.747 | 38.820 | 30.340 | 1.00 | 35.58 | | C |
| ANISOU | 3313 | CB | ASP | B | 55 | 4164 | 4455 | 4899 | −742 | 0 | 197 | C |
| ATOM | 3314 | CG | ASP | B | 55 | −9.575 | 38.318 | 29.199 | 1.00 | 38.53 | | C |
| ANISOU | 3314 | CG | ASP | B | 55 | 4414 | 4687 | 5537 | −922 | −227 | 59 | C |
| ATOM | 3315 | OD1 | ASP | B | 55 | −9.027 | 38.123 | 28.089 | 1.00 | 34.08 | | O |
| ANISOU | 3315 | OD1 | ASP | B | 55 | 3999 | 4111 | 4839 | −924 | −459 | −79 | O |
| ATOM | 3316 | OD2 | ASP | B | 55 | −10.794 | 38.161 | 29.402 | 1.00 | 50.95 | | O |
| ANISOU | 3316 | OD2 | ASP | B | 55 | 5738 | 6159 | 7463 | −1047 | −182 | 81 | O |
| ATOM | 3317 | N | ILE | B | 56 | −5.942 | 38.792 | 29.342 | 1.00 | 26.23 | | N |
| ANISOU | 3317 | N | ILE | B | 56 | 3452 | 3406 | 3110 | −527 | −186 | 84 | N |
| ATOM | 3318 | CA | ILE | B | 56 | −4.860 | 38.418 | 28.451 | 1.00 | 28.03 | | C |
| ANISOU | 3318 | CA | ILE | B | 56 | 3882 | 3613 | 3156 | −475 | −295 | 12 | C |
| ATOM | 3319 | C | ILE | B | 56 | −5.280 | 37.318 | 27.474 | 1.00 | 32.08 | | C |
| ANISOU | 3319 | C | ILE | B | 56 | 4462 | 3928 | 3798 | −597 | −416 | −81 | C |
| ATOM | 3320 | O | ILE | B | 56 | −4.998 | 37.394 | 26.277 | 1.00 | 35.74 | | O |
| ANISOU | 3320 | O | ILE | B | 56 | 5038 | 4377 | 4164 | −580 | −607 | −195 | O |
| ATOM | 3321 | CB | ILE | B | 56 | −3.634 | 37.996 | 29.267 | 1.00 | 25.70 | | C |
| ANISOU | 3321 | CB | ILE | B | 56 | 3742 | 3351 | 2670 | −330 | −132 | 100 | C |
| ATOM | 3322 | CG1 | ILE | B | 56 | −3.060 | 39.243 | 29.943 | 1.00 | 25.83 | | C |
| ANISOU | 3322 | CG1 | ILE | B | 56 | 3704 | 3566 | 2544 | −200 | −110 | 122 | C |
| ATOM | 3323 | CG2 | ILE | B | 56 | −2.604 | 37.332 | 28.371 | 1.00 | 21.36 | | C |
| ANISOU | 3323 | CG2 | ILE | B | 56 | 3395 | 2736 | 1987 | −282 | −198 | 49 | C |
| ATOM | 3324 | CD1 | ILE | B | 56 | −1.995 | 38.968 | 30.917 | 1.00 | 28.39 | | C |
| ANISOU | 3324 | CD1 | ILE | B | 56 | 4136 | 3948 | 2704 | −39 | 8 | 188 | C |
| ATOM | 3325 | N | ASP | B | 57 | −5.982 | 36.309 | 27.975 | 1.00 | 33.22 | | N |
| ANISOU | 3325 | N | ASP | B | 57 | 4550 | 3901 | 4172 | −709 | −299 | −37 | N |
| ATOM | 3326 | CA | ASP | B | 57 | −6.321 | 35.161 | 27.149 | 1.00 | 28.01 | | C |
| ANISOU | 3326 | CA | ASP | B | 57 | 3961 | 3016 | 3666 | −833 | −411 | −144 | C |
| ATOM | 3327 | C | ASP | B | 57 | −7.345 | 35.405 | 26.030 | 1.00 | 35.14 | | C |
| ANISOU | 3327 | C | ASP | B | 57 | 4733 | 3868 | 4750 | −958 | −715 | −323 | C |
| ATOM | 3328 | O | ASP | B | 57 | −7.181 | 34.889 | 24.923 | 1.00 | 38.38 | | O |
| ANISOU | 3328 | O | ASP | B | 57 | 5302 | 4173 | 5106 | −970 | −925 | −474 | O |
| ATOM | 3329 | CB | ASP | B | 57 | −6.856 | 34.043 | 28.021 | 1.00 | 31.66 | | C |
| ANISOU | 3329 | CB | ASP | B | 57 | 4368 | 3272 | 4388 | −932 | −175 | −43 | C |
| ATOM | 3330 | CG | ASP | B | 57 | −7.069 | 32.780 | 27.246 | 1.00 | 39.40 | | C |
| ANISOU | 3330 | CG | ASP | B | 57 | 5444 | 3986 | 5540 | −1062 | −272 | −162 | C |
| ATOM | 3331 | OD1 | ASP | B | 57 | −6.111 | 32.363 | 26.552 | 1.00 | 35.83 | | O |
| ANISOU | 3331 | OD1 | ASP | B | 57 | 5252 | 3511 | 4851 | −975 | −357 | −227 | O |
| ATOM | 3332 | OD2 | ASP | B | 57 | −8.194 | 32.230 | 27.304 | 1.00 | 49.20 | | O |
| ANISOU | 3332 | OD2 | ASP | B | 57 | 6492 | 5030 | 7172 | −1248 | −265 | −198 | O |
| ATOM | 3333 | N | GLU | B | 58 | −8.406 | 36.160 | 26.311 | 1.00 | 31.98 | | N |
| ANISOU | 3333 | N | GLU | B | 58 | 4058 | 3537 | 4557 | −1029 | −748 | −315 | N |
| ATOM | 3334 | CA | GLU | B | 58 | −9.542 | 36.230 | 25.381 | 1.00 | 38.97 | | C |
| ANISOU | 3334 | CA | GLU | B | 58 | 4770 | 4351 | 5687 | −1153 | −1046 | −488 | C |
| ATOM | 3335 | C | GLU | B | 58 | −9.557 | 37.495 | 24.523 | 1.00 | 38.45 | | C |
| ANISOU | 3335 | C | GLU | B | 58 | 4708 | 4481 | 5419 | −1038 | −1290 | −575 | C |
| ATOM | 3336 | O | GLU | B | 58 | −9.755 | 37.421 | 23.316 | 1.00 | 41.07 | | O |
| ANISOU | 3336 | O | GLU | B | 58 | 5126 | 4772 | 5706 | −1024 | −1596 | −753 | O |
| ATOM | 3337 | CB | GLU | B | 58 | −10.855 | 36.095 | 26.156 | 1.00 | 40.35 | | C |
| ANISOU | 3337 | CB | GLU | B | 58 | 4597 | 4431 | 6303 | −1314 | −927 | −426 | C |
| ATOM | 3338 | CG | GLU | B | 58 | −10.891 | 34.788 | 26.951 | 1.00 | 54.79 | | C |
| ANISOU | 3338 | CG | GLU | B | 58 | 6437 | 6021 | 8361 | −1418 | −646 | −324 | C |
| ATOM | 3339 | CD | GLU | B | 58 | −12.210 | 34.517 | 27.663 | 1.00 | 68.88 | | C |
| ANISOU | 3339 | CD | GLU | B | 58 | 7870 | 7651 | 10649 | −1583 | −476 | −247 | C |
| ATOM | 3340 | OE1 | GLU | B | 58 | −12.893 | 35.481 | 28.079 | 1.00 | 77.41 | | O |
| ANISOU | 3340 | OE1 | GLU | B | 58 | 8715 | 8869 | 11827 | −1563 | −432 | −176 | O |
| ATOM | 3341 | OE2 | GLU | B | 58 | −12.547 | 33.323 | 27.818 | 1.00 | 69.46 | | O |
| ANISOU | 3341 | OE2 | GLU | B | 58 | 7904 | 7448 | 11040 | −1729 | −358 | −247 | O |
| ATOM | 3342 | N | TYR | B | 59 | −9.344 | 38.645 | 25.149 | 1.00 | 35.23 | | N |
| ANISOU | 3342 | N | TYR | B | 59 | 4233 | 4272 | 4880 | −937 | −1151 | −452 | N |
| ATOM | 3343 | CA | TYR | B | 59 | −9.178 | 39.902 | 24.430 | 1.00 | 33.81 | | C |
| ANISOU | 3343 | CA | TYR | B | 59 | 4094 | 4268 | 4486 | −802 | −1310 | −498 | C |
| ATOM | 3344 | C | TYR | B | 59 | −7.724 | 40.118 | 23.984 | 1.00 | 32.75 | | C |
| ANISOU | 3344 | C | TYR | B | 59 | 4262 | 4197 | 3986 | −637 | −1268 | −481 | C |
| ATOM | 3345 | O | TYR | B | 59 | −7.475 | 40.574 | 22.861 | 1.00 | 28.20 | | O |
| ANISOU | 3345 | O | TYR | B | 59 | 3834 | 3654 | 3225 | −524 | −1445 | −567 | O |
| ATOM | 3346 | CB | TYR | B | 59 | −9.629 | 41.086 | 25.307 | 1.00 | 30.45 | | C |
| ANISOU | 3346 | CB | TYR | B | 59 | 3454 | 3999 | 4115 | −770 | −1168 | −381 | C |
| ATOM | 3347 | CG | TYR | B | 59 | −11.131 | 41.166 | 25.544 | 1.00 | 37.80 | | C |
| ANISOU | 3347 | CG | TYR | B | 59 | 4059 | 4894 | 5411 | −894 | −1223 | −393 | C |
| ATOM | 3348 | CD2 | TYR | B | 59 | −11.705 | 40.657 | 26.713 | 1.00 | 39.18 | | C |
| ANISOU | 3348 | CD2 | TYR | B | 59 | 4048 | 4983 | 5858 | −998 | −972 | −270 | C |
| ATOM | 3349 | CD1 | TYR | B | 59 | −11.975 | 41.779 | 24.614 | 1.00 | 33.47 | | C |
| ANISOU | 3349 | CD1 | TYR | B | 59 | 3384 | 4393 | 4941 | −879 | −1509 | −513 | C |
| ATOM | 3350 | CE2 | TYR | B | 59 | −13.075 | 40.748 | 26.937 | 1.00 | 39.49 | | C |
| ANISOU | 3350 | CE2 | TYR | B | 59 | 3754 | 4972 | 6278 | −1107 | −984 | −262 | C |
| ATOM | 3351 | CE1 | TYR | B | 59 | −13.342 | 41.866 | 24.826 | 1.00 | 32.47 | | C |
| ANISOU | 3351 | CE1 | TYR | B | 59 | 2916 | 4234 | 5186 | −986 | −1569 | −525 | C |
| ATOM | 3352 | CZ | TYR | B | 59 | −13.886 | 41.354 | 25.987 | 1.00 | 45.40 | | C |
| ANISOU | 3352 | CZ | TYR | B | 59 | 4344 | 5776 | 7132 | −1110 | −1294 | −396 | C |
| ATOM | 3353 | OH | TYR | B | 59 | −15.247 | 41.443 | 26.196 | 1.00 | 51.00 | | O |
| ANISOU | 3353 | OH | TYR | B | 59 | 4682 | 6437 | 8259 | −1214 | −1319 | −391 | O |
| ATOM | 3354 | N | ALA | B | 60 | −6.789 | 39.783 | 24.881 | 1.00 | 24.19 | | N |
| ANISOU | 3354 | N | ALA | B | 60 | 3263 | 3120 | 2809 | −606 | −1022 | −364 | N |
| ATOM | 3355 | CA | ALA | B | 60 | −5.346 | 40.022 | 24.724 | 1.00 | 31.82 | | C |
| ANISOU | 3355 | CA | ALA | B | 60 | 4444 | 4151 | 3497 | −456 | −933 | −322 | C |
| ATOM | 3356 | C | ALA | B | 60 | −5.020 | 41.531 | 24.779 | 1.00 | 28.78 | | C |
| ANISOU | 3356 | C | ALA | B | 60 | 4001 | 3937 | 2996 | −346 | −903 | −283 | C |
| ATOM | 3357 | O | ALA | B | 60 | −3.934 | 41.986 | 24.384 | 1.00 | 26.71 | | O |
| ANISOU | 3357 | O | ALA | B | 60 | 3877 | 3719 | 2554 | −222 | −857 | −267 | O |
| ATOM | 3358 | CB | ALA | B | 60 | −4.817 | 39.376 | 23.427 | 1.00 | 23.15 | | C |
| ANISOU | 3358 | CB | ALA | B | 60 | 3604 | 2945 | 2249 | −394 | −1074 | −422 | C |
| ATOM | 3359 | N | TYR | B | 61 | −5.972 | 42.294 | 25.298 | 1.00 | 26.35 | | N |
| ANISOU | 3359 | N | TYR | B | 61 | 3478 | 3707 | 2827 | −394 | −904 | −261 | N |
| ATOM | 3360 | CA | TYR | B | 61 | −5.760 | 43.701 | 25.582 | 1.00 | 23.08 | | C |
| ANISOU | 3360 | CA | TYR | B | 61 | 2994 | 3434 | 2342 | −305 | −844 | −220 | C |
| ATOM | 3361 | C | TYR | B | 61 | −6.750 | 44.131 | 26.646 | 1.00 | 25.87 | | C |
| ANISOU | 3361 | C | TYR | B | 61 | 3121 | 3842 | 2864 | −365 | −761 | −162 | C |
| ATOM | 3362 | O | TYR | B | 61 | −7.590 | 43.336 | 27.077 | 1.00 | 30.22 | | O |
| ANISOU | 3362 | O | TYR | B | 61 | 3562 | 4315 | 3604 | −473 | −736 | −143 | O |
| ATOM | 3363 | CB | TYR | B | 61 | −5.913 | 44.557 | 24.318 | 1.00 | 19.68 | | C |
| ANISOU | 3363 | CB | TYR | B | 61 | 2623 | 3033 | 1821 | −218 | −1001 | −283 | C |
| ATOM | 3364 | CG | TYR | B | 61 | −7.227 | 44.357 | 23.611 | 1.00 | 21.64 | | C |
| ANISOU | 3364 | CG | TYR | B | 61 | 2781 | 3243 | 2197 | −275 | −1225 | −370 | C |
| ATOM | 3365 | CD1 | TYR | B | 61 | −8.391 | 44.940 | 24.096 | 1.00 | 22.29 | | C |
| ANISOU | 3365 | CD1 | TYR | B | 61 | 2616 | 3386 | 2468 | −332 | −1247 | −352 | C |
| ATOM | 3366 | CD2 | TYR | B | 61 | −7.312 | 43.589 | 22.457 | 1.00 | 34.65 | | C |
| ANISOU | 3366 | CD2 | TYR | B | 61 | 4590 | 4790 | 3785 | −259 | −1428 | −481 | C |
| ATOM | 3367 | CE1 | TYR | B | 61 | −9.608 | 44.747 | 23.458 | 1.00 | 24.48 | | C |
| ANISOU | 3367 | CE1 | TYR | B | 61 | 2764 | 3627 | 2909 | −384 | −1479 | −445 | C |
| ATOM | 3368 | CE2 | TYR | B | 61 | −8.521 | 43.387 | 21.809 | 1.00 | 25.43 | | C |
| ANISOU | 3368 | CE2 | TYR | B | 61 | 3317 | 3584 | 2760 | −303 | −1657 | −588 | C |
| ATOM | 3369 | CZ | TYR | B | 61 | −9.669 | 43.973 | 22.309 | 1.00 | 26.11 | | C |
| ANISOU | 3369 | CZ | TYR | B | 61 | 3118 | 3736 | 3066 | −372 | −1708 | −576 | C |
| ATOM | 3370 | OH | TYR | B | 61 | −10.885 | 43.810 | 21.671 | 1.00 | 28.71 | | O |
| ANISOU | 3370 | OH | TYR | B | 61 | 3309 | 4036 | 3562 | −406 | −1882 | −666 | O |
| ATOM | 3371 | N | TYR | B | 62 | −6.644 | 45.392 | 27.056 | 1.00 | 28.84 | | N |
| ANISOU | 3371 | N | TYR | B | 62 | 3435 | 4333 | 3192 | −289 | −697 | −131 | N |
| ATOM | 3372 | CA | TYR | B | 62 | −7.562 | 46.009 | 28.012 | 1.00 | 23.35 | | C |
| ANISOU | 3372 | CA | TYR | B | 62 | 2553 | 3698 | 2623 | −304 | −603 | −72 | C |
| ATOM | 3373 | C | TYR | B | 62 | −8.076 | 47.268 | 27.373 | 1.00 | 24.18 | | C |
| ANISOU | 3373 | C | TYR | B | 62 | 2583 | 3875 | 2731 | −250 | −698 | −101 | C |
| ATOM | 3374 | O | TYR | B | 62 | −7.325 | 47.979 | 26.707 | 1.00 | 25.76 | | O |
| ANISOU | 3374 | O | TYR | B | 62 | 2896 | 4102 | 2789 | −163 | −734 | −132 | O |
| ATOM | 3375 | CB | TYR | B | 62 | −6.877 | 46.316 | 29.338 | 1.00 | 21.70 | | C |
| ANISOU | 3375 | CB | TYR | B | 62 | 2376 | 3548 | 2321 | −228 | −418 | −12 | C |
| ATOM | 3376 | CG | TYR | B | 62 | −6.553 | 45.076 | 30.119 | 1.00 | 23.63 | | C |
| ANISOU | 3376 | CG | TYR | B | 62 | 2695 | 3726 | 2559 | −244 | −301 | 43 | C |
| ATOM | 3377 | CD1 | TYR | B | 62 | −5.491 | 44.252 | 29.742 | 1.00 | 20.94 | | C |
| ANISOU | 3377 | CD1 | TYR | B | 62 | 2516 | 3335 | 2107 | −231 | −330 | 16 | C |
| ATOM | 3378 | CD2 | TYR | B | 62 | −7.324 | 44.705 | 31.216 | 1.00 | 20.74 | | C |
| ANISOU | 3378 | CD2 | TYR | B | 62 | 2250 | 3333 | 2298 | −250 | −134 | 138 | C |
| ATOM | 3379 | CE1 | TYR | B | 62 | −5.201 | 43.105 | 30.441 | 1.00 | 23.65 | | C |
| ANISOU | 3379 | CE1 | TYR | B | 62 | 2942 | 3610 | 2436 | −224 | −213 | 77 | C |
| ATOM | 3380 | CE2 | TYR | B | 62 | −7.040 | 43.556 | 31.927 | 1.00 | 20.52 | | C |
| ANISOU | 3380 | CE2 | TYR | B | 62 | 2316 | 3226 | 2253 | −236 | 7 | 210 | C |
| ATOM | 3381 | CZ | TYR | B | 62 | −5.977 | 42.758 | 31.540 | 1.00 | 24.60 | | C |
| ANISOU | 3381 | CZ | TYR | B | 62 | 2997 | 3700 | 2651 | −224 | −42 | 176 | C |
| ATOM | 3382 | OH | TYR | B | 62 | −5.694 | 41.602 | 32.243 | 1.00 | 25.88 | | O |
| ANISOU | 3382 | OH | TYR | B | 62 | 3269 | 3776 | 2787 | −189 | 108 | 257 | O |
| ATOM | 3383 | N | PHE | B | 63 | −9.367 | 47.517 | 27.520 | 1.00 | 27.76 | | N |
| ANISOU | 3383 | N | PHE | B | 63 | 2840 | 4341 | 3365 | −292 | −725 | −81 | N |
| ATOM | 3384 | CA | PHE | B | 63 | −9.984 | 48.638 | 26.828 | 1.00 | 26.07 | | C |
| ANISOU | 3384 | CA | PHE | B | 63 | 2551 | 4193 | 3161 | −224 | −835 | −106 | C |
| ATOM | 3385 | C | PHE | B | 63 | −10.900 | 49.437 | 27.739 | 1.00 | 27.03 | | C |
| ANISOU | 3385 | C | PHE | B | 63 | 2479 | 4376 | 3414 | −205 | −710 | −31 | C |
| ATOM | 3386 | O | PHE | B | 63 | −11.268 | 48.986 | 28.826 | 1.00 | 26.95 | | O |
| ANISOU | 3386 | O | PHE | B | 63 | 2377 | 4344 | 3520 | −252 | −547 | 42 | O |
| ATOM | 3387 | CB | PHE | B | 63 | −10.766 | 48.144 | 25.617 | 1.00 | 24.93 | | C |
| ANISOU | 3387 | CB | PHE | B | 63 | 2362 | 4002 | 3107 | −259 | −1092 | −193 | C |
| ATOM | 3388 | CG | PHE | B | 63 | −11.964 | 47.317 | 25.968 | 1.00 | 33.72 | | C |
| ANISOU | 3388 | CG | PHE | B | 63 | 3239 | 5051 | 4524 | −397 | −1131 | −194 | C |
| ATOM | 3389 | CD1 | PHE | B | 63 | −11.831 | 45.955 | 26.251 | 1.00 | 30.68 | | C |
| ANISOU | 3389 | CD1 | PHE | B | 63 | 2871 | 4542 | 4244 | −524 | −1094 | −203 | C |
| ATOM | 3390 | CD2 | PHE | B | 63 | −13.229 | 47.897 | 26.022 | 1.00 | 26.10 | | C |
| ANISOU | 3390 | CD2 | PHE | B | 63 | 2017 | 4128 | 3772 | −398 | −1184 | −177 | C |
| ATOM | 3391 | CE1 | PHE | B | 63 | −12.932 | 45.189 | 26.567 | 1.00 | 31.45 | | C |
| ANISOU | 3391 | CE1 | PHE | B | 63 | 2728 | 4540 | 4680 | −664 | −1097 | −198 | C |
| ATOM | 3392 | CE2 | PHE | B | 63 | −14.339 | 47.131 | 26.349 | 1.00 | 31.95 | | C |
| ANISOU | 3392 | CE2 | PHE | B | 63 | 2492 | 4784 | 4863 | −535 | −1196 | −172 | C |
| ATOM | 3393 | CZ | PHE | B | 63 | −14.187 | 45.771 | 26.617 | 1.00 | 31.90 | | C |
| ANISOU | 3393 | CZ | PHE | B | 63 | 2500 | 4635 | 4987 | −677 | −1146 | −183 | C |
| ATOM | 3394 | N | LEU | B | 64 | −11.260 | 50.631 | 27.286 | 1.00 | 32.32 | | N |
| ANISOU | 3394 | N | LEU | B | 64 | 3110 | 5113 | 4057 | −110 | −761 | −35 | N |
| ATOM | 3395 | CA | LEU | B | 64 | −12.192 | 51.480 | 28.018 | 1.00 | 32.68 | | C |
| ANISOU | 3395 | CA | LEU | B | 64 | 2978 | 5214 | 4224 | −68 | −648 | 36 | C |
| ATOM | 3396 | C | LEU | B | 64 | −13.100 | 52.169 | 27.031 | 1.00 | 27.76 | | C |
| ANISOU | 3396 | C | LEU | B | 64 | 2246 | 4634 | 3669 | −2 | −823 | 11 | C |
| ATOM | 3397 | O | LEU | B | 64 | −12.887 | 52.068 | 25.827 | 1.00 | 25.62 | | O |
| ANISOU | 3397 | O | LEU | B | 64 | 2079 | 4351 | 3303 | 37 | −1025 | −65 | O |
| ATOM | 3398 | CB | LEU | B | 64 | −11.463 | 52.515 | 28.882 | 1.00 | 37.03 | | C |
| ANISOU | 3398 | CB | LEU | B | 64 | 3635 | 5808 | 4627 | 29 | −462 | 66 | C |
| ATOM | 3399 | CG | LEU | B | 64 | −10.911 | 53.750 | 28.176 | 1.00 | 39.79 | | C |
| ANISOU | 3399 | CG | LEU | B | 64 | 4096 | 6181 | 4841 | 138 | −497 | 30 | C |
| ATOM | 3400 | CD1 | LEU | B | 64 | −10.575 | 54.807 | 29.186 | 1.00 | 34.55 | | C |
| ANISOU | 3400 | CD1 | LEU | B | 64 | 3464 | 5537 | 4125 | 214 | −321 | 46 | C |
| ATOM | 3401 | CD2 | LEU | B | 64 | −9.671 | 53.381 | 27.421 | 1.00 | 44.20 | | C |
| ANISOU | 3401 | CD2 | LEU | B | 64 | 4844 | 6693 | 5257 | 133 | −561 | −28 | C |
| ATOM | 3402 | N | ASP | B | 65 | −14.138 | 52.825 | 27.545 | 1.00 | 38.91 | | N |
| ANISOU | 3402 | N | ASP | B | 65 | 3457 | 6089 | 5236 | 36 | −745 | 78 | N |
| ATOM | 3403 | CA | ASP | B | 65 | −15.062 | 53.600 | 26.716 | 1.00 | 39.65 | | C |
| ANISOU | 3403 | CA | ASP | B | 65 | 3427 | 6239 | 5398 | 134 | −904 | 66 | C |
| ATOM | 3404 | C | ASP | B | 65 | −14.757 | 55.083 | 26.794 | 1.00 | 36.79 | | C |
| ANISOU | 3404 | C | ASP | B | 65 | 3174 | 5930 | 4877 | 293 | −784 | 109 | C |
| ATOM | 3405 | O | ASP | B | 65 | −14.373 | 55.594 | 27.843 | 1.00 | 34.59 | | O |
| ANISOU | 3405 | O | ASP | B | 65 | 2943 | 5650 | 4550 | 311 | −556 | 160 | O |
| ATOM | 3406 | CB | ASP | B | 65 | −16.514 | 53.379 | 27.136 | 1.00 | 46.31 | | C |
| ANISOU | 3406 | CB | ASP | B | 65 | 3935 | 7088 | 6574 | 84 | −899 | 119 | C |
| ATOM | 3407 | CG | ASP | B | 65 | −16.990 | 51.970 | 26.882 | 1.00 | 55.57 | | C |
| ANISOU | 3407 | CG | ASP | B | 65 | 4951 | 8176 | 7986 | −83 | −1048 | 60 | C |
| ATOM | 3408 | OD1 | ASP | B | 65 | −16.557 | 51.359 | 25.886 | 1.00 | 54.50 | | O |
| ANISOU | 3408 | OD1 | ASP | B | 65 | 4947 | 8007 | 7754 | −112 | −1288 | −60 | O |
| ATOM | 3409 | OD2 | ASP | B | 65 | −17.809 | 51.474 | 27.681 | 1.00 | 65.87 | | O |
| ANISOU | 3409 | OD2 | ASP | B | 65 | 6008 | 9428 | 9591 | −177 | −906 | 135 | O |
| ATOM | 3410 | N | ILE | B | 66 | −14.936 | 55.768 | 25.671 | 1.00 | 37.14 | | N |
| ANISOU | 3410 | N | ILE | B | 66 | 3273 | 6006 | 4833 | 426 | −943 | 80 | N |
| ATOM | 3411 | CA | ILE | B | 66 | −14.772 | 57.207 | 25.618 | 1.00 | 40.65 | | C |
| ANISOU | 3411 | CA | ILE | B | 66 | 3812 | 6474 | 5159 | 588 | −822 | 129 | C |
| ATOM | 3412 | C | ILE | B | 66 | −15.902 | 57.801 | 24.758 | 1.00 | 43.33 | | C |
| ANISOU | 3412 | C | ILE | B | 66 | 4029 | 6876 | 5557 | 739 | −996 | 143 | C |
| ATOM | 3413 | O | ILE | B | 66 | −16.405 | 57.143 | 23.843 | 1.00 | 40.54 | | O |
| ANISOU | 3413 | O | ILE | B | 66 | 3632 | 6524 | 5247 | 738 | −1261 | 76 | O |
| ATOM | 3414 | CB | ILE | B | 66 | −13.370 | 57.552 | 25.082 | 1.00 | 42.21 | | C |
| ANISOU | 3414 | CB | ILE | B | 66 | 4301 | 6611 | 5125 | 640 | −767 | 99 | C |
| ATOM | 3415 | CG1 | ILE | B | 66 | −12.340 | 57.228 | 26.167 | 1.00 | 49.78 | | C |
| ANISOU | 3415 | CG1 | ILE | B | 66 | 5330 | 7525 | 6062 | 520 | −586 | 87 | C |
| ATOM | 3416 | CG2 | ILE | B | 66 | −13.264 | 58.990 | 24.660 | 1.00 | 38.98 | | C |
| ANISOU | 3416 | CG2 | ILE | B | 66 | 4000 | 6190 | 4619 | 823 | −670 | 147 | C |
| ATOM | 3417 | CD1 | ILE | B | 66 | −11.002 | 57.876 | 25.985 | 1.00 | 59.58 | | C |
| ANISOU | 3417 | CD1 | ILE | B | 66 | 6778 | 8694 | 7165 | 566 | −467 | 66 | C |
| ATOM | 3418 | N | ASP | B | 67 | −16.323 | 59.029 | 25.062 | 1.00 | 39.11 | | N |
| ANISOU | 3418 | N | ASP | B | 67 | 3459 | 6372 | 5030 | 874 | −855 | 220 | N |
| ATOM | 3419 | CA | ASP | B | 67 | −17.370 | 59.676 | 24.275 | 1.00 | 39.21 | | C |
| ANISOU | 3419 | CA | ASP | B | 67 | 3364 | 6449 | 5084 | 1052 | −1010 | 245 | C |
| ATOM | 3420 | C | ASP | B | 67 | −16.762 | 60.536 | 23.205 | 1.00 | 40.04 | | C |
| ANISOU | 3420 | C | ASP | B | 67 | 3748 | 6531 | 4933 | 1257 | −1032 | 250 | C |
| ATOM | 3421 | O | ASP | B | 67 | −15.803 | 61.267 | 23.447 | 1.00 | 43.24 | | O |
| ANISOU | 3421 | O | ASP | B | 67 | 4354 | 6864 | 5209 | 1288 | −802 | 286 | O |
| ATOM | 3422 | CB | ASP | B | 67 | −18.282 | 60.520 | 25.158 | 1.00 | 38.93 | | C |
| ANISOU | 3422 | CB | ASP | B | 67 | 3134 | 6448 | 5211 | 1113 | −827 | 344 | C |
| ATOM | 3423 | CG | ASP | B | 67 | −19.054 | 59.685 | 26.140 | 1.00 | 51.21 | | C |
| ANISOU | 3423 | CG | ASP | B | 67 | 4417 | 7994 | 7048 | 945 | −768 | 366 | C |
| ATOM | 3424 | OD1 | ASP | B | 67 | −19.699 | 58.709 | 25.707 | 1.00 | 47.98 | | O |
| ANISOU | 3424 | OD1 | ASP | B | 67 | 3851 | 7549 | 6831 | 837 | −983 | 302 | O |
| ATOM | 3425 | OD2 | ASP | B | 67 | −18.990 | 59.981 | 27.348 | 1.00 | 62.74 | | O |
| ANISOU | 3425 | OD2 | ASP | B | 67 | 5839 | 9456 | 8544 | 929 | −495 | 445 | O |
| ATOM | 3426 | N | ILE | B | 68 | −17.321 | 60.438 | 22.009 | 1.00 | 38.94 | | N |
| ANISOU | 3426 | N | ILE | B | 68 | 3676 | 6366 | 4753 | 1343 | −1262 | 210 | N |
| ATOM | 3427 | CA | ILE | B | 68 | −16.805 | 61.187 | 20.878 | 1.00 | 36.88 | | C |
| ANISOU | 3427 | CA | ILE | B | 68 | 3716 | 6065 | 4231 | 1564 | −1259 | 230 | C |
| ATOM | 3428 | C | ILE | B | 68 | −17.908 | 61.793 | 20.015 | 1.00 | 39.62 | | C |
| ANISOU | 3428 | C | ILE | B | 68 | 4048 | 6431 | 4576 | 1740 | −1408 | 246 | C |
| ATOM | 3429 | O | ILE | B | 68 | −18.848 | 61.113 | 19.621 | 1.00 | 45.08 | | O |
| ANISOU | 3429 | O | ILE | B | 68 | 4586 | 7141 | 5403 | 1673 | −1661 | 183 | O |
| ATOM | 3430 | CB | ILE | B | 68 | −15.931 | 60.302 | 19.996 | 1.00 | 36.70 | | C |
| ANISOU | 3430 | CB | ILE | B | 68 | 3936 | 5973 | 4038 | 1528 | −1368 | 151 | C |
| ATOM | 3431 | CG1 | ILE | B | 68 | −14.708 | 59.837 | 20.781 | 1.00 | 38.01 | | C |
| ANISOU | 3431 | CG1 | ILE | B | 68 | 4145 | 6118 | 4177 | 1389 | −1206 | 147 | C |
| ATOM | 3432 | CG2 | ILE | B | 68 | −15.514 | 61.050 | 18.739 | 1.00 | 35.51 | | C |
| ANISOU | 3432 | CG2 | ILE | B | 68 | 4106 | 5763 | 3625 | 1784 | −1331 | 184 | C |
| ATOM | 3433 | CD1 | ILE | B | 68 | −13.754 | 59.054 | 19.964 | 1.00 | 42.54 | | C |
| ANISOU | 3433 | CD1 | ILE | B | 68 | 4970 | 6607 | 4585 | 1370 | −1259 | 90 | C |
| ATOM | 3434 | N | GLY | B | 69 | −17.779 | 63.079 | 19.719 | 1.00 | 34.34 | | N |
| ANISOU | 3434 | N | GLY | B | 69 | 2948 | 5066 | 5033 | 1143 | −438 | −31 | N |
| ATOM | 3435 | CA | GLY | B | 69 | −18.716 | 63.743 | 18.845 | 1.00 | 34.49 | | C |
| ANISOU | 3435 | CA | GLY | B | 69 | 2898 | 4973 | 5235 | 1257 | −629 | 64 | C |
| ATOM | 3436 | C | GLY | B | 69 | −19.873 | 64.367 | 19.586 | 1.00 | 45.76 | | C |
| ANISOU | 3436 | C | GLY | B | 69 | 3971 | 6524 | 6893 | 1444 | −549 | 24 | C |
| ATOM | 3437 | O | GLY | B | 69 | −19.955 | 64.301 | 20.810 | 1.00 | 48.14 | | O |
| ANISOU | 3437 | O | GLY | B | 69 | 4090 | 7031 | 7170 | 1486 | −314 | −91 | O |
| ATOM | 3438 | N | THR | B | 70 | −20.779 | 64.961 | 18.818 | 1.00 | 49.91 | | N |
| ANISOU | 3438 | N | THR | B | 70 | 4394 | 6932 | 7636 | 1561 | −751 | 123 | N |
| ATOM | 3439 | CA | THR | B | 70 | −21.920 | 65.672 | 19.359 | 1.00 | 56.26 | | C |
| ANISOU | 3439 | CA | THR | B | 70 | 4836 | 7816 | 8723 | 1783 | −696 | 77 | C |
| ATOM | 3440 | C | THR | B | 70 | −23.112 | 65.414 | 18.441 | 1.00 | 62.84 | | C |
| ANISOU | 3440 | C | THR | B | 70 | 5480 | 8622 | 9773 | 1771 | −999 | 302 | C |
| ATOM | 3441 | O | THR | B | 70 | −23.140 | 65.894 | 17.304 | 1.00 | 65.50 | | O |
| ANISOU | 3441 | O | THR | B | 70 | 5997 | 8720 | 10171 | 1787 | −1270 | 412 | O |
| ATOM | 3442 | CB | THR | B | 70 | −21.646 | 67.180 | 19.478 | 1.00 | 55.37 | | C |
| ANISOU | 3442 | CB | THR | B | 70 | 4798 | 7485 | 8755 | 2025 | −644 | −94 | C |
| ATOM | 3443 | OG1 | THR | B | 70 | −20.419 | 67.387 | 20.187 | 1.00 | 56.45 | | O |
| ANISOU | 3443 | OG1 | THR | B | 70 | 5158 | 7606 | 8683 | 1996 | −427 | −285 | O |
| ATOM | 3444 | CG2 | THR | B | 70 | −22.793 | 67.880 | 20.204 | 1.00 | 51.97 | | C |
| ANISOU | 3444 | CG2 | THR | B | 70 | 3966 | 7156 | 8626 | 2297 | −538 | −210 | C |
| ATOM | 3445 | N | PRO | B | 71 | −24.097 | 64.642 | 18.924 | 1.00 | 57.58 | | N |
| ANISOU | 3445 | N | PRO | B | 71 | 4449 | 8206 | 9221 | 1721 | −971 | 394 | N |
| ATOM | 3446 | CA | PRO | B | 71 | −24.154 | 64.064 | 20.272 | 1.00 | 52.34 | | C |
| ANISOU | 3446 | CA | PRO | B | 71 | 3555 | 7863 | 8467 | 1680 | −651 | 315 | C |
| ATOM | 3447 | C | PRO | B | 71 | −23.148 | 62.929 | 20.465 | 1.00 | 49.09 | | C |
| ANISOU | 3447 | C | PRO | B | 71 | 3399 | 7512 | 7741 | 1414 | −604 | 341 | C |
| ATOM | 3448 | O | PRO | B | 71 | −22.561 | 62.457 | 19.499 | 1.00 | 47.46 | | O |
| ANISOU | 3448 | O | PRO | B | 71 | 3498 | 7121 | 7415 | 1266 | −823 | 417 | O |
| ATOM | 3449 | CB | PRO | B | 71 | −25.590 | 63.559 | 20.364 | 1.00 | 54.55 | | C |
| ANISOU | 3449 | CB | PRO | B | 71 | 3428 | 8336 | 8963 | 1645 | −720 | 468 | C |
| ATOM | 3450 | CG | PRO | B | 71 | −25.951 | 63.245 | 18.963 | 1.00 | 49.41 | | C |
| ANISOU | 3450 | CG | PRO | B | 71 | 2918 | 7472 | 8384 | 1530 | −1127 | 667 | C |
| ATOM | 3451 | CD | PRO | B | 71 | −25.248 | 64.234 | 18.103 | 1.00 | 48.36 | | C |
| ANISOU | 3451 | CD | PRO | B | 71 | 3088 | 7028 | 8259 | 1662 | −1282 | 621 | C |
| ATOM | 3452 | N | GLU | B | 72 | −22.927 | 62.530 | 21.709 | 1.00 | 55.02 | | N |
| ANISOU | 3452 | N | GLU | B | 72 | 4031 | 8521 | 8353 | 1367 | −320 | 267 | N |
| ATOM | 3453 | CA | GLU | B | 72 | −21.864 | 61.585 | 22.035 | 1.00 | 50.23 | | C |
| ANISOU | 3453 | CA | GLU | B | 72 | 3665 | 7945 | 7475 | 1145 | −270 | 273 | C |
| ATOM | 3454 | C | GLU | B | 72 | −22.052 | 60.226 | 21.368 | 1.00 | 45.95 | | C |
| ANISOU | 3454 | C | GLU | B | 72 | 3146 | 7373 | 6938 | 888 | −532 | 499 | C |
| ATOM | 3455 | O | GLU | B | 72 | −23.152 | 59.673 | 21.344 | 1.00 | 45.20 | | O |
| ANISOU | 3455 | O | GLU | B | 72 | 2743 | 7409 | 7023 | 813 | −639 | 685 | O |
| ATOM | 3456 | CB | GLU | B | 72 | −21.775 | 61.415 | 23.556 | 1.00 | 58.18 | | C |
| ANISOU | 3456 | CB | GLU | B | 72 | 4502 | 9267 | 8336 | 1136 | 54 | 193 | C |
| ATOM | 3457 | CG | GLU | B | 72 | −21.369 | 62.692 | 24.286 | 1.00 | 71.37 | | C |
| ANISOU | 3457 | CG | GLU | B | 72 | 6227 | 10943 | 9946 | 1379 | 300 | −94 | C |
| ATOM | 3458 | CD | GLU | B | 72 | −21.308 | 62.531 | 25.793 | 1.00 | 82.74 | | C |
| ANISOU | 3458 | CD | GLU | B | 72 | 7547 | 12708 | 11182 | 1360 | 610 | −189 | C |
| ATOM | 3459 | OE1 | GLU | B | 72 | −21.967 | 61.613 | 26.334 | 1.00 | 86.92 | | O |
| ANISOU | 3459 | OE1 | GLU | B | 72 | 7878 | 13466 | 11681 | 1183 | 668 | −3 | O |
| ATOM | 3460 | OE2 | GLU | B | 72 | −20.603 | 63.339 | 26.436 | 1.00 | 86.07 | | O |
| ANISOU | 3460 | OE2 | GLU | B | 72 | 8157 | 13077 | 11469 | 1474 | 766 | −437 | O |
| ATOM | 3461 | N | GLN | B | 73 | −20.966 | 59.689 | 20.830 | 1.00 | 42.72 | | N |
| ANISOU | 3461 | N | GLN | B | 73 | 3093 | 6784 | 6355 | 756 | −640 | 473 | N |
| ATOM | 3462 | CA | GLN | B | 73 | −20.958 | 58.307 | 20.378 | 1.00 | 40.94 | | C |
| ANISOU | 3462 | CA | GLN | B | 73 | 2925 | 6516 | 6114 | 517 | −869 | 626 | C |
| ATOM | 3463 | C | GLN | B | 73 | −19.950 | 57.566 | 21.239 | 1.00 | 45.11 | | C |
| ANISOU | 3463 | C | GLN | B | 73 | 3566 | 7112 | 6464 | 381 | −724 | 587 | C |
| ATOM | 3464 | O | GLN | B | 73 | −18.766 | 57.892 | 21.246 | 1.00 | 48.05 | | O |
| ANISOU | 3464 | O | GLN | B | 73 | 4210 | 7371 | 6676 | 423 | −623 | 429 | O |
| ATOM | 3465 | CB | GLN | B | 73 | −20.616 | 58.193 | 18.879 | 1.00 | 37.48 | | C |
| ANISOU | 3465 | CB | GLN | B | 73 | 2806 | 5801 | 5634 | 490 | −1157 | 617 | C |
| ATOM | 3466 | CG | GLN | B | 73 | −21.626 | 58.865 | 17.929 | 1.00 | 44.22 | | C |
| ANISOU | 3466 | CG | GLN | B | 73 | 3576 | 6569 | 6658 | 597 | −1376 | 697 | C |
| ATOM | 3467 | CD | GLN | B | 73 | −21.353 | 58.580 | 16.451 | 1.00 | 51.39 | | C |
| ANISOU | 3467 | CD | GLN | B | 73 | 4817 | 7249 | 7459 | 530 | −1688 | 712 | C |
| ATOM | 3468 | OE1 | GLN | B | 73 | −21.125 | 57.435 | 16.049 | 1.00 | 52.32 | | O |
| ANISOU | 3468 | OE1 | GLN | B | 73 | 5071 | 7308 | 7501 | 358 | −1866 | 734 | O |
| ATOM | 3469 | NE2 | GLN | B | 73 | −21.391 | 59.626 | 15.634 | 1.00 | 51.23 | | N |
| ANISOU | 3469 | NE2 | GLN | B | 73 | 4936 | 7099 | 7429 | 667 | −1768 | 698 | N |
| ATOM | 3470 | N | ARG | B | 74 | −20.436 | 56.587 | 21.991 | 1.00 | 46.67 | | N |
| ANISOU | 3470 | N | ARG | B | 74 | 3529 | 7495 | 6707 | 208 | −724 | 758 | N |
| ATOM | 3471 | CA | ARG | B | 74 | −19.589 | 55.824 | 22.890 | 1.00 | 42.48 | | C |
| ANISOU | 3471 | CA | ARG | B | 74 | 3072 | 7038 | 6031 | 60 | −624 | 774 | C |
| ATOM | 3472 | C | ARG | B | 74 | −18.748 | 54.840 | 22.078 | 1.00 | 43.17 | | C |
| ANISOU | 3472 | C | ARG | B | 74 | 3451 | 6854 | 6099 | −77 | −873 | 766 | C |
| ATOM | 3473 | O | ARG | B | 74 | −19.275 | 54.087 | 21.269 | 1.00 | 48.14 | | O |
| ANISOU | 3473 | O | ARG | B | 74 | 4073 | 7358 | 6860 | −184 | −1155 | 874 | O |
| ATOM | 3474 | CB | ARG | B | 74 | −20.454 | 55.139 | 23.938 | 1.00 | 46.54 | | C |
| ANISOU | 3474 | CB | ARG | B | 74 | 3229 | 7851 | 6603 | −96 | −550 | 1006 | C |
| ATOM | 3475 | CG | ARG | B | 74 | −19.710 | 54.543 | 25.100 | 1.00 | 53.69 | | C |
| ANISOU | 3475 | CG | ARG | B | 74 | 4168 | 8898 | 7333 | −239 | −415 | 1056 | C |
| ATOM | 3476 | CD | ARG | B | 74 | −20.713 | 54.287 | 26.216 | 1.00 | 65.37 | | C |
| ANISOU | 3476 | CD | ARG | B | 74 | 5312 | 10720 | 8804 | −334 | −240 | 1255 | C |
| ATOM | 3477 | NE | ARG | B | 74 | −20.177 | 53.505 | 27.320 | 1.00 | 72.59 | | N |
| ANISOU | 3477 | NE | ARG | B | 74 | 6264 | 11771 | 9546 | −528 | −171 | 1387 | N |
| ATOM | 3478 | CZ | ARG | B | 74 | −20.607 | 53.613 | 28.573 | 1.00 | 84.19 | | C |
| ANISOU | 3478 | CZ | ARG | B | 74 | 7584 | 13562 | 10841 | −555 | 87 | 1462 | C |
| ATOM | 3479 | NH1 | ARG | B | 74 | −21.574 | 54.476 | 28.873 | 1.00 | 84.28 | | N |
| ANISOU | 3479 | NH1 | ARG | B | 74 | 7400 | 13769 | 10853 | −383 | 317 | 1376 | N |
| ATOM | 3480 | NH2 | ARG | B | 74 | −20.066 | 52.869 | 29.530 | 1.00 | 90.65 | | N |
| ANISOU | 3480 | NH2 | ARG | B | 74 | 8462 | 14499 | 11484 | −747 | 102 | 1615 | N |
| ATOM | 3481 | N | ILE | B | 75 | −17.435 | 54.850 | 22.286 | 1.00 | 44.41 | | N |
| ANISOU | 3481 | N | ILE | B | 75 | 3856 | 6914 | 6105 | −64 | −778 | 621 | N |
| ATOM | 3482 | CA | ILE | B | 75 | −16.542 | 54.030 | 21.475 | 1.00 | 38.78 | | C |
| ANISOU | 3482 | CA | ILE | B | 75 | 3415 | 5941 | 5378 | −140 | −971 | 558 | C |
| ATOM | 3483 | C | ILE | B | 75 | −15.511 | 53.346 | 22.341 | 1.00 | 36.99 | | C |
| ANISOU | 3483 | C | ILE | B | 75 | 3250 | 5712 | 5092 | −245 | −913 | 557 | C |
| ATOM | 3484 | O | ILE | B | 75 | −14.861 | 53.986 | 23.158 | 1.00 | 27.65 | | O |
| ANISOU | 3484 | O | ILE | B | 75 | 2086 | 4630 | 3788 | −180 | −691 | 473 | O |
| ATOM | 3485 | CB | ILE | B | 75 | −15.833 | 54.888 | 20.403 | 1.00 | 41.52 | | C |
| ANISOU | 3485 | CB | ILE | B | 75 | 4042 | 6107 | 5626 | 24 | −942 | 355 | C |
| ATOM | 3486 | CG1 | ILE | B | 75 | −16.845 | 55.354 | 19.363 | 1.00 | 53.92 | | C |
| ANISOU | 3486 | CG1 | ILE | B | 75 | 5590 | 7634 | 7264 | 94 | −1097 | 395 | C |
| ATOM | 3487 | CG2 | ILE | B | 75 | −14.703 | 54.123 | 19.725 | 1.00 | 36.13 | | C |
| ANISOU | 3487 | CG2 | ILE | B | 75 | 3631 | 5209 | 4889 | −22 | −1046 | 242 | C |
| ATOM | 3488 | CD1 | ILE | B | 75 | −16.647 | 56.780 | 18.951 | 1.00 | 62.08 | | C |
| ANISOU | 3488 | CD1 | ILE | B | 75 | 6727 | 8632 | 8227 | 284 | −961 | 283 | C |
| ATOM | 3489 | N | SER | B | 76 | −15.358 | 52.041 | 22.144 | 1.00 | 36.14 | | N |
| ANISOU | 3489 | N | SER | B | 76 | 3180 | 5461 | 5089 | −406 | −1149 | 646 | N |
| ATOM | 3490 | CA | SER | B | 76 | −14.371 | 51.270 | 22.883 | 1.00 | 35.64 | | C |
| ANISOU | 3490 | CA | SER | B | 76 | 3173 | 5345 | 5022 | −511 | −1160 | 668 | C |
| ATOM | 3491 | C | SER | B | 76 | −12.999 | 51.365 | 22.232 | 1.00 | 33.40 | | C |
| ANISOU | 3491 | C | SER | B | 76 | 3168 | 4836 | 4687 | −400 | −1137 | 429 | C |
| ATOM | 3492 | O | SER | B | 76 | −12.866 | 51.234 | 21.012 | 1.00 | 34.51 | | O |
| ANISOU | 3492 | O | SER | B | 76 | 3480 | 4789 | 4843 | −333 | −1253 | 296 | O |
| ATOM | 3493 | CB | SER | B | 76 | −14.800 | 49.815 | 22.962 | 1.00 | 30.32 | | C |
| ANISOU | 3493 | CB | SER | B | 76 | 2406 | 4573 | 4540 | −728 | −1454 | 876 | C |
| ATOM | 3494 | OG | SER | B | 76 | −15.087 | 49.364 | 21.664 | 1.00 | 31.31 | | O |
| ANISOU | 3494 | OG | SER | B | 76 | 2658 | 4466 | 4773 | −713 | −1704 | 792 | O |
| ATOM | 3495 | N | LEU | B | 77 | −11.983 | 51.597 | 23.056 | 1.00 | 26.76 | | N |
| ANISOU | 3495 | N | LEU | B | 77 | 2362 | 4032 | 3774 | −386 | −985 | 378 | N |
| ATOM | 3496 | CA | LEU | B | 77 | −10.636 | 51.800 | 22.566 | 1.00 | 27.89 | | C |
| ANISOU | 3496 | CA | LEU | B | 77 | 2709 | 3998 | 3890 | −280 | −921 | 170 | C |
| ATOM | 3497 | C | LEU | B | 77 | −9.640 | 50.984 | 23.350 | 1.00 | 30.32 | | C |
| ANISOU | 3497 | C | LEU | B | 77 | 3013 | 4226 | 4280 | −372 | −986 | 208 | C |
| ATOM | 3498 | O | LEU | B | 77 | −9.685 | 50.944 | 24.584 | 1.00 | 27.72 | | O |
| ANISOU | 3498 | O | LEU | B | 77 | 2563 | 4060 | 3910 | −473 | −950 | 355 | O |
| ATOM | 3499 | CB | LEU | B | 77 | −10.246 | 53.273 | 22.642 | 1.00 | 31.87 | | C |
| ANISOU | 3499 | CB | LEU | B | 77 | 3265 | 4592 | 4251 | −133 | −663 | 38 | C |
| ATOM | 3500 | CG | LEU | B | 77 | −11.169 | 54.260 | 21.945 | 1.00 | 38.61 | | C |
| ANISOU | 3500 | CG | LEU | B | 77 | 4117 | 5507 | 5047 | −23 | −601 | 10 | C |
| ATOM | 3501 | CD1 | LEU | B | 77 | −10.774 | 55.658 | 22.331 | 1.00 | 36.43 | | C |
| ANISOU | 3501 | CD1 | LEU | B | 77 | 3864 | 5299 | 4677 | 100 | −377 | −94 | C |
| ATOM | 3502 | CD2 | LEU | B | 77 | −11.095 | 54.068 | 20.440 | 1.00 | 41.59 | | C |
| ANISOU | 3502 | CD2 | LEU | B | 77 | 4673 | 5704 | 5426 | 32 | −715 | −81 | C |
| ATOM | 3503 | N | ILE | B | 78 | −8.726 | 50.351 | 22.627 | 1.00 | 28.34 | | N |
| ANISOU | 3503 | N | ILE | B | 78 | 2897 | 3733 | 4137 | −328 | −1083 | 69 | N |
| ATOM | 3504 | CA | ILE | B | 78 | −7.618 | 49.642 | 23.244 | 1.00 | 26.03 | | C |
| ANISOU | 3504 | CA | ILE | B | 78 | 2601 | 3319 | 3973 | −376 | −1157 | 75 | C |
| ATOM | 3505 | C | ILE | B | 78 | −6.683 | 50.615 | 23.951 | 1.00 | 27.13 | | C |
| ANISOU | 3505 | C | ILE | B | 78 | 2740 | 3558 | 4010 | −320 | −943 | 14 | C |
| ATOM | 3506 | O | ILE | B | 78 | −6.255 | 51.620 | 23.370 | 1.00 | 27.85 | | O |
| ANISOU | 3506 | O | ILE | B | 78 | 2917 | 3654 | 4009 | −185 | −752 | −151 | O |
| ATOM | 3507 | CB | ILE | B | 78 | −6.810 | 48.847 | 22.213 | 1.00 | 25.01 | | C |
| ANISOU | 3507 | CB | ILE | B | 78 | 2598 | 2905 | 3998 | −290 | −1271 | −116 | C |
| ATOM | 3508 | CG1 | ILE | B | 78 | −7.708 | 47.853 | 21.483 | 1.00 | 26.58 | | C |
| ANISOU | 3508 | CG1 | ILE | B | 78 | 2830 | 2965 | 4306 | −347 | −1533 | −93 | C |
| ATOM | 3509 | CG2 | ILE | B | 78 | −5.632 | 48.153 | 22.873 | 1.00 | 25.49 | | C |
| ANISOU | 3509 | CG2 | ILE | B | 78 | 2619 | 2820 | 4247 | −316 | −1357 | −111 | C |
| ATOM | 3510 | CD1 | ILE | B | 78 | −6.941 | 46.913 | 20.546 | 1.00 | 29.22 | | C |
| ANISOU | 3510 | CD1 | ILE | B | 78 | 3299 | 3004 | 4801 | −251 | −1675 | −320 | C |
| ATOM | 3511 | N | LEU | B | 79 | −6.383 | 50.332 | 25.213 | 1.00 | 27.48 | | N |
| ANISOU | 3511 | N | LEU | B | 79 | 2692 | 3681 | 4066 | −439 | −997 | 164 | N |
| ATOM | 3512 | CA | LEU | B | 79 | −5.543 | 51.222 | 25.990 | 1.00 | 23.07 | | C |
| ANISOU | 3512 | CA | LEU | B | 79 | 2140 | 3216 | 3408 | −407 | −846 | 108 | C |
| ATOM | 3513 | C | LEU | B | 79 | −4.075 | 50.951 | 25.703 | 1.00 | 26.78 | | C |
| ANISOU | 3513 | C | LEU | B | 79 | 2655 | 3464 | 4056 | −345 | −879 | −19 | C |
| ATOM | 3514 | O | LEU | B | 79 | −3.524 | 49.944 | 26.151 | 1.00 | 23.92 | | O |
| ANISOU | 3514 | O | LEU | B | 79 | 2245 | 2973 | 3871 | −425 | −1076 | 72 | O |
| ATOM | 3515 | CB | LEU | B | 79 | −5.845 | 51.070 | 27.478 | 1.00 | 24.15 | | C |
| ANISOU | 3515 | CB | LEU | B | 79 | 2179 | 3566 | 3431 | −567 | −897 | 320 | C |
| ATOM | 3516 | CG | LEU | B | 79 | −5.112 | 52.073 | 28.380 | 1.00 | 35.83 | | C |
| ANISOU | 3516 | CG | LEU | B | 79 | 3687 | 5168 | 4760 | −542 | −766 | 244 | C |
| ATOM | 3517 | CD1 | LEU | B | 79 | −5.658 | 53.467 | 28.166 | 1.00 | 23.08 | | C |
| ANISOU | 3517 | CD1 | LEU | B | 79 | 2106 | 3695 | 2968 | −411 | −528 | 91 | C |
| ATOM | 3518 | CD2 | LEU | B | 79 | −5.254 | 51.675 | 29.838 | 1.00 | 35.73 | | C |
| ANISOU | 3518 | CD2 | LEU | B | 79 | 3609 | 5356 | 4610 | −720 | −862 | 460 | C |
| ATOM | 3519 | N | ASP | B | 80 | −3.421 | 51.887 | 25.008 | 1.00 | 27.98 | | N |
| ANISOU | 3519 | N | ASP | B | 80 | 2878 | 3574 | 4180 | −206 | −688 | −210 | N |
| ATOM | 3520 | CA | ASP | B | 80 | −2.097 | 51.616 | 24.440 | 1.00 | 23.18 | | C |
| ANISOU | 3520 | CA | ASP | B | 80 | 2282 | 2765 | 3761 | −122 | −675 | −347 | C |
| ATOM | 3521 | C | ASP | B | 80 | −1.021 | 52.644 | 24.773 | 1.00 | 24.85 | | C |
| ANISOU | 3521 | C | ASP | B | 80 | 2475 | 2993 | 3975 | −85 | −527 | −421 | C |
| ATOM | 3522 | O | ASP | B | 80 | −0.893 | 53.671 | 24.101 | 1.00 | 21.51 | | O |
| ANISOU | 3522 | O | ASP | B | 80 | 2110 | 2595 | 3467 | 1 | −331 | −526 | O |
| ATOM | 3523 | CB | ASP | B | 80 | −2.207 | 51.491 | 22.918 | 1.00 | 22.18 | | C |
| ANISOU | 3523 | CB | ASP | B | 80 | 2252 | 2537 | 3638 | 5 | −595 | −509 | C |
| ATOM | 3524 | CG | ASP | B | 80 | −0.888 | 51.145 | 22.262 | 1.00 | 31.02 | | C |
| ANISOU | 3524 | CG | ASP | B | 80 | 3361 | 3486 | 4938 | 112 | −537 | −672 | C |
| ATOM | 3525 | OD1 | ASP | B | 80 | −0.012 | 50.578 | 22.936 | 1.00 | 31.28 | | O |
| ANISOU | 3525 | OD1 | ASP | B | 80 | 3289 | 3415 | 5183 | 83 | −647 | −642 | O |
| ATOM | 3526 | OD2 | ASP | B | 80 | −0.737 | 51.381 | 21.049 | 1.00 | 36.37 | | O |
| ANISOU | 3526 | OD2 | ASP | B | 80 | 4129 | 4141 | 5549 | 227 | −386 | −825 | O |
| ATOM | 3527 | N | THR | B | 81 | −0.190 | 52.339 | 25.762 | 1.00 | 22.31 | | N |
| ANISOU | 3527 | N | THR | B | 81 | 2070 | 2632 | 3776 | −160 | −651 | −351 | N |
| ATOM | 3528 | CA | THR | B | 81 | 0.881 | 53.269 | 26.093 | 1.00 | 27.80 | | C |
| ANISOU | 3528 | CA | THR | B | 81 | 2733 | 3316 | 4515 | −143 | −558 | −416 | C |
| ATOM | 3529 | C | THR | B | 81 | 2.028 | 53.169 | 25.088 | 1.00 | 27.43 | | C |
| ANISOU | 3529 | C | THR | B | 81 | 2632 | 3099 | 4690 | −30 | −453 | −551 | C |
| ATOM | 3530 | O | THR | B | 81 | 3.024 | 53.856 | 25.229 | 1.00 | 25.12 | | O |
| ANISOU | 3530 | O | THR | B | 81 | 2275 | 2774 | 4496 | −24 | −379 | −589 | O |
| ATOM | 3531 | CB | THR | B | 81 | 1.426 | 53.039 | 27.516 | 1.00 | 30.54 | | C |
| ANISOU | 3531 | CB | THR | B | 81 | 3011 | 3685 | 4906 | −272 | −756 | −291 | C |
| ATOM | 3532 | OG1 | THR | B | 81 | 1.946 | 51.710 | 27.627 | 1.00 | 29.42 | | O |
| ANISOU | 3532 | OG1 | THR | B | 81 | 2781 | 3380 | 5017 | −304 | −972 | −211 | O |
| ATOM | 3533 | CG2 | THR | B | 81 | 0.318 | 53.235 | 28.560 | 1.00 | 30.76 | | C |
| ANISOU | 3533 | CG2 | THR | B | 81 | 3091 | 3945 | 4650 | −384 | −806 | −165 | C |
| ATOM | 3534 | N | GLY | B | 82 | 1.877 | 52.337 | 24.057 | 1.00 | 33.47 | | N |
| ANISOU | 3534 | N | GLY | B | 82 | 3419 | 3767 | 5529 | 58 | −440 | −631 | N |
| ATOM | 3535 | CA | GLY | B | 82 | 2.920 | 52.163 | 23.050 | 1.00 | 30.23 | | C |
| ANISOU | 3535 | CA | GLY | B | 82 | 2954 | 3237 | 5297 | 188 | −299 | −787 | C |
| ATOM | 3536 | C | GLY | B | 82 | 2.681 | 52.860 | 21.716 | 1.00 | 30.82 | | C |
| ANISOU | 3536 | C | GLY | B | 82 | 3140 | 3381 | 5189 | 287 | −38 | −905 | C |
| ATOM | 3537 | O | GLY | B | 82 | 3.455 | 52.694 | 20.771 | 1.00 | 31.90 | | O |
| ANISOU | 3537 | O | GLY | B | 82 | 3244 | 3467 | 5411 | 398 | 121 | −1039 | O |
| ATOM | 3538 | N | SER | B | 83 | 1.614 | 53.648 | 21.625 | 1.00 | 29.00 | | N |
| ANISOU | 3538 | N | SER | B | 83 | 3036 | 3278 | 4703 | 252 | 11 | −849 | N |
| ATOM | 3539 | CA | SER | B | 83 | 1.418 | 54.475 | 20.440 | 1.00 | 26.55 | | C |
| ANISOU | 3539 | CA | SER | B | 83 | 2839 | 3035 | 4215 | 322 | 229 | −911 | C |
| ATOM | 3540 | C | SER | B | 83 | 0.797 | 55.809 | 20.808 | 1.00 | 26.55 | | C |
| ANISOU | 3540 | C | SER | B | 83 | 2895 | 3135 | 4056 | 269 | 282 | −820 | C |
| ATOM | 3541 | O | SER | B | 83 | 0.424 | 56.034 | 21.971 | 1.00 | 28.06 | | O |
| ANISOU | 3541 | O | SER | B | 83 | 3050 | 3370 | 4243 | 194 | 165 | −745 | O |
| ATOM | 3542 | CB | SER | B | 83 | 0.563 | 53.752 | 19.404 | 1.00 | 27.94 | | C |
| ANISOU | 3542 | CB | SER | B | 83 | 3151 | 3208 | 4258 | 386 | 192 | −988 | C |
| ATOM | 3543 | OG | SER | B | 83 | −0.796 | 53.759 | 19.780 | 1.00 | 30.85 | | O |
| ANISOU | 3543 | OG | SER | B | 83 | 3582 | 3641 | 4498 | 322 | 43 | −888 | O |
| ATOM | 3544 | N | SER | B | 84 | 0.692 | 56.706 | 19.829 | 1.00 | 24.55 | | N |
| ANISOU | 3544 | N | SER | B | 84 | 2738 | 2922 | 3669 | 311 | 452 | −829 | N |
| ATOM | 3545 | CA | SER | B | 84 | 0.333 | 58.099 | 20.164 | 1.00 | 32.56 | | C |
| ANISOU | 3545 | CA | SER | B | 84 | 3789 | 3974 | 4610 | 277 | 495 | −755 | C |
| ATOM | 3546 | C | SER | B | 84 | −1.032 | 58.523 | 19.604 | 1.00 | 34.68 | | C |
| ANISOU | 3546 | C | SER | B | 84 | 4189 | 4307 | 4681 | 312 | 472 | −716 | C |
| ATOM | 3547 | O | SER | B | 84 | −1.549 | 59.574 | 19.961 | 1.00 | 27.03 | | O |
| ANISOU | 3547 | O | SER | B | 84 | 3242 | 3352 | 3675 | 308 | 469 | −671 | O |
| ATOM | 3548 | CB | SER | B | 84 | 1.433 | 59.078 | 19.698 | 1.00 | 29.23 | | C |
| ANISOU | 3548 | CB | SER | B | 84 | 3334 | 3508 | 4265 | 265 | 674 | −735 | C |
| ATOM | 3549 | OG | SER | B | 84 | 1.456 | 59.262 | 18.285 | 1.00 | 30.79 | | O |
| ANISOU | 3549 | OG | SER | B | 84 | 3629 | 3741 | 4328 | 311 | 837 | −728 | O |
| ATOM | 3550 | N | SER | B | 85 | −1.630 | 57.697 | 18.750 | 1.00 | 32.35 | | N |
| ANISOU | 3550 | N | SER | B | 85 | 3975 | 4034 | 4283 | 351 | 429 | −746 | N |
| ATOM | 3551 | CA | SER | B | 85 | −2.844 | 58.124 | 18.071 | 1.00 | 28.13 | | C |
| ANISOU | 3551 | CA | SER | B | 85 | 3558 | 3549 | 3581 | 380 | 387 | −695 | C |
| ATOM | 3552 | C | SER | B | 85 | −4.129 | 57.778 | 18.823 | 1.00 | 28.52 | | C |
| ANISOU | 3552 | C | SER | B | 85 | 3556 | 3657 | 3626 | 358 | 214 | −645 | C |
| ATOM | 3553 | O | SER | B | 85 | −4.120 | 57.037 | 19.804 | 1.00 | 25.80 | | O |
| ANISOU | 3553 | O | SER | B | 85 | 3106 | 3325 | 3370 | 307 | 122 | −639 | O |
| ATOM | 3554 | CB | SER | B | 85 | −2.889 | 57.526 | 16.668 | 1.00 | 24.66 | | C |
| ANISOU | 3554 | CB | SER | B | 85 | 3256 | 3114 | 2998 | 425 | 409 | −752 | C |
| ATOM | 3555 | OG | SER | B | 85 | −1.832 | 58.044 | 15.885 | 1.00 | 32.50 | | O |
| ANISOU | 3555 | OG | SER | B | 85 | 4293 | 4112 | 3945 | 443 | 618 | −768 | O |
| ATOM | 3556 | N | LEU | B | 86 | −5.227 | 58.385 | 18.381 | 1.00 | 25.32 | | N |
| ANISOU | 3556 | N | LEU | B | 86 | 3205 | 3291 | 3123 | 390 | 171 | −584 | N |
| ATOM | 3557 | CA | LEU | B | 86 | −6.569 | 57.981 | 18.781 | 1.00 | 23.33 | | C |
| ANISOU | 3557 | CA | LEU | B | 86 | 2884 | 3114 | 2868 | 377 | 19 | −524 | C |
| ATOM | 3558 | C | LEU | B | 86 | −7.320 | 57.802 | 17.475 | 1.00 | 32.17 | | C |
| ANISOU | 3558 | C | LEU | B | 86 | 4126 | 4220 | 3877 | 404 | −78 | −501 | C |
| ATOM | 3559 | O | LEU | B | 86 | −7.489 | 58.754 | 16.716 | 1.00 | 34.26 | | O |
| ANISOU | 3559 | O | LEU | B | 86 | 4488 | 4470 | 4059 | 452 | −36 | −462 | O |
| ATOM | 3560 | CB | LEU | B | 86 | −7.234 | 59.011 | 19.693 | 1.00 | 21.03 | | C |
| ANISOU | 3560 | CB | LEU | B | 86 | 2492 | 2894 | 2604 | 408 | 49 | −484 | C |
| ATOM | 3561 | CG | LEU | B | 86 | −8.431 | 58.590 | 20.556 | 1.00 | 31.14 | | C |
| ANISOU | 3561 | CG | LEU | B | 86 | 3618 | 4309 | 3906 | 383 | −43 | −420 | C |
| ATOM | 3562 | CD1 | LEU | B | 86 | −8.953 | 59.773 | 21.351 | 1.00 | 29.14 | | C |
| ANISOU | 3562 | CD1 | LEU | B | 86 | 3278 | 4130 | 3663 | 461 | 40 | −439 | C |
| ATOM | 3563 | CD2 | LEU | B | 86 | −9.561 | 57.984 | 19.732 | 1.00 | 32.00 | | C |
| ANISOU | 3563 | CD2 | LEU | B | 86 | 3724 | 4434 | 4001 | 374 | −199 | −342 | C |
| ATOM | 3564 | N | SER | B | 87 | −7.758 | 56.579 | 17.204 | 1.00 | 34.11 | | N |
| ANISOU | 3564 | N | SER | B | 87 | 4380 | 4454 | 4127 | 364 | −238 | −515 | N |
| ATOM | 3565 | CA | SER | B | 87 | −8.332 | 56.272 | 15.905 | 1.00 | 29.17 | | C |
| ANISOU | 3565 | CA | SER | B | 87 | 3908 | 3801 | 3376 | 381 | −365 | −528 | C |
| ATOM | 3566 | C | SER | B | 87 | −9.278 | 55.090 | 15.947 | 1.00 | 26.64 | | C |
| ANISOU | 3566 | C | SER | B | 87 | 3534 | 3462 | 3124 | 314 | −617 | −501 | C |
| ATOM | 3567 | O | SER | B | 87 | −9.228 | 54.269 | 16.865 | 1.00 | 26.55 | | O |
| ANISOU | 3567 | O | SER | B | 87 | 3389 | 3440 | 3258 | 246 | −679 | −481 | O |
| ATOM | 3568 | CB | SER | B | 87 | −7.216 | 55.989 | 14.911 | 1.00 | 31.04 | | C |
| ANISOU | 3568 | CB | SER | B | 87 | 4320 | 3984 | 3488 | 418 | −257 | −663 | C |
| ATOM | 3569 | OG | SER | B | 87 | −6.490 | 54.833 | 15.316 | 1.00 | 27.08 | | O |
| ANISOU | 3569 | OG | SER | B | 87 | 3769 | 3413 | 3106 | 402 | −275 | −776 | O |
| ATOM | 3570 | N | PHE | B | 88 | −10.097 | 54.990 | 14.904 | 1.00 | 31.45 | | N |
| ANISOU | 3570 | N | PHE | B | 88 | 4260 | 4057 | 3634 | 319 | −787 | −486 | N |
| ATOM | 3571 | CA | PHE | B | 88 | −11.174 | 54.011 | 14.807 | 1.00 | 30.78 | | C |
| ANISOU | 3571 | CA | PHE | B | 88 | 4121 | 3939 | 3634 | 241 | −1077 | −434 | C |
| ATOM | 3572 | C | PHE | B | 88 | −11.790 | 54.064 | 13.419 | 1.00 | 38.60 | | C |
| ANISOU | 3572 | C | PHE | B | 88 | 5310 | 4899 | 4457 | 260 | −1260 | −456 | C |
| ATOM | 3573 | O | PHE | B | 88 | −11.627 | 55.053 | 12.713 | 1.00 | 45.26 | | O |
| ANISOU | 3573 | O | PHE | B | 88 | 6288 | 5783 | 5126 | 326 | −1157 | −444 | O |
| ATOM | 3574 | CB | PHE | B | 88 | −12.242 | 54.308 | 15.850 | 1.00 | 29.92 | | C |
| ANISOU | 3574 | CB | PHE | B | 88 | 3744 | 3937 | 3687 | 191 | −1117 | −250 | C |
| ATOM | 3575 | CG | PHE | B | 88 | −12.460 | 55.773 | 16.065 | 1.00 | 31.08 | | C |
| ANISOU | 3575 | CG | PHE | B | 88 | 3831 | 4176 | 3800 | 281 | −947 | −188 | C |
| ATOM | 3576 | CD2 | PHE | B | 88 | −11.946 | 56.403 | 17.182 | 1.00 | 28.66 | | C |
| ANISOU | 3576 | CD2 | PHE | B | 88 | 3406 | 3940 | 3543 | 311 | −727 | −192 | C |
| ATOM | 3577 | CD1 | PHE | B | 88 | −13.156 | 56.525 | 15.138 | 1.00 | 29.24 | | C |
| ANISOU | 3577 | CD1 | PHE | B | 88 | 3676 | 3937 | 3496 | 338 | −1038 | −133 | C |
| ATOM | 3578 | CE2 | PHE | B | 88 | −12.126 | 57.753 | 17.375 | 1.00 | 32.58 | | C |
| ANISOU | 3578 | CE2 | PHE | B | 88 | 3862 | 4478 | 4037 | 408 | −597 | −171 | C |
| ATOM | 3579 | CE1 | PHE | B | 88 | −13.338 | 57.870 | 15.328 | 1.00 | 36.84 | | C |
| ANISOU | 3579 | CE1 | PHE | B | 88 | 4584 | 4936 | 4477 | 432 | −913 | −79 | C |
| ATOM | 3580 | CZ | PHE | B | 88 | −12.825 | 58.489 | 16.458 | 1.00 | 37.62 | | C |
| ANISOU | 3580 | CZ | PHE | B | 88 | 4563 | 5084 | 4645 | 474 | −689 | −112 | C |
| ATOM | 3581 | N | PRO | B | 89 | −12.500 | 52.998 | 13.014 | 1.00 | 42.01 | | N |
| ANISOU | 3581 | N | PRO | B | 89 | 5772 | 5249 | 4941 | 186 | −1562 | −473 | N |
| ATOM | 3582 | CA | PRO | B | 89 | −13.221 | 53.063 | 11.735 | 1.00 | 39.82 | | C |
| ANISOU | 3582 | CA | PRO | B | 89 | 5686 | 4949 | 4495 | 189 | −1794 | −481 | C |
| ATOM | 3583 | C | PRO | B | 89 | −14.243 | 54.193 | 11.689 | 1.00 | 38.32 | | C |
| ANISOU | 3583 | C | PRO | B | 89 | 5383 | 4850 | 4325 | 204 | −1840 | −276 | C |
| ATOM | 3584 | O | PRO | B | 89 | −14.847 | 54.522 | 12.706 | 1.00 | 35.55 | | O |
| ANISOU | 3584 | O | PRO | B | 89 | 4748 | 4567 | 4190 | 186 | −1798 | −128 | O |
| ATOM | 3585 | CB | PRO | B | 89 | −13.922 | 51.706 | 11.663 | 1.00 | 34.28 | | C |
| ANISOU | 3585 | CB | PRO | B | 89 | 4955 | 4122 | 3946 | 80 | −2149 | −503 | C |
| ATOM | 3586 | CG | PRO | B | 89 | −13.089 | 50.800 | 12.495 | 1.00 | 33.28 | | C |
| ANISOU | 3586 | CG | PRO | B | 89 | 4750 | 3911 | 3983 | 54 | −2065 | −594 | C |
| ATOM | 3587 | CD | PRO | B | 89 | −12.524 | 51.644 | 13.599 | 1.00 | 35.18 | | C |
| ANISOU | 3587 | CD | PRO | B | 89 | 4809 | 4278 | 4281 | 92 | −1731 | −499 | C |
| ATOM | 3588 | N | CYS | B | 90 | −14.471 | 54.752 | 10.509 | 1.00 | 36.21 | | N |
| ANISOU | 3588 | N | CYS | B | 90 | 5335 | 4589 | 3835 | 240 | −1940 | −267 | N |
| ATOM | 3589 | CA | CYS | B | 90 | −15.541 | 55.712 | 10.355 | 1.00 | 35.33 | | C |
| ANISOU | 3589 | CA | CYS | B | 90 | 5115 | 4521 | 3789 | 257 | −2066 | −64 | C |
| ATOM | 3590 | C | CYS | B | 90 | −16.472 | 55.271 | 9.247 | 1.00 | 40.81 | | C |
| ANISOU | 3590 | C | CYS | B | 90 | 5952 | 5162 | 4390 | 196 | −2465 | −32 | C |
| ATOM | 3591 | O | CYS | B | 90 | −16.084 | 54.478 | 8.398 | 1.00 | 43.63 | | O |
| ANISOU | 3591 | O | CYS | B | 90 | 6584 | 5465 | 4528 | 166 | −2589 | −201 | O |
| ATOM | 3592 | CB | CYS | B | 90 | −14.973 | 57.095 | 10.077 | 1.00 | 43.97 | | C |
| ANISOU | 3592 | CB | CYS | B | 90 | 6312 | 5657 | 4739 | 350 | −1834 | −10 | C |
| ATOM | 3593 | SG | CYS | B | 90 | −13.969 | 57.698 | 11.458 | 1.00 | 51.63 | | S |
| ANISOU | 3593 | SG | CYS | B | 90 | 7095 | 6665 | 5858 | 410 | −1423 | −46 | S |
| ATOM | 3594 | N | ALA | B | 91 | −17.685 | 55.820 | 9.247 | 1.00 | 39.39 | | N |
| ANISOU | 3594 | N | ALA | B | 91 | 5588 | 4998 | 4382 | 190 | −2673 | 170 | N |
| ATOM | 3595 | CA | ALA | B | 91 | −18.817 | 55.297 | 8.472 | 1.00 | 42.30 | | C |
| ANISOU | 3595 | CA | ALA | B | 91 | 5983 | 5307 | 4783 | 104 | −3123 | 245 | C |
| ATOM | 3596 | C | ALA | B | 91 | −18.582 | 55.078 | 6.978 | 1.00 | 63.80 | | C |
| ANISOU | 3596 | C | ALA | B | 91 | 9119 | 7987 | 7136 | 80 | −3285 | 133 | C |
| ATOM | 3597 | O | ALA | B | 91 | −19.293 | 54.286 | 6.352 | 1.00 | 71.19 | | O |
| ANISOU | 3597 | O | ALA | B | 91 | 10093 | 8847 | 8111 | −11 | −3514 | 106 | O |
| ATOM | 3598 | CB | ALA | B | 91 | −20.018 | 56.199 | 8.660 | 1.00 | 43.34 | | C |
| ANISOU | 3598 | CB | ALA | B | 91 | 5828 | 5472 | 5166 | 137 | −3228 | 487 | C |
| ATOM | 3599 | N | GLY | B | 92 | −17.606 | 55.752 | 6.388 | 1.00 | 60.18 | | N |
| ANISOU | 3599 | N | GLY | B | 92 | 8955 | 7584 | 6325 | 154 | −3102 | 69 | N |
| ATOM | 3600 | CA | GLY | B | 92 | −17.353 | 55.509 | 4.976 | 1.00 | 63.03 | | C |
| ANISOU | 3600 | CA | GLY | B | 92 | 9699 | 7956 | 6293 | 127 | −3200 | −43 | C |
| ATOM | 3601 | C | GLY | B | 92 | −16.706 | 54.155 | 4.740 | 1.00 | 55.34 | | C |
| ANISOU | 3601 | C | GLY | B | 92 | 8894 | 6930 | 5204 | 104 | −3173 | −345 | C |
| ATOM | 3602 | O | GLY | B | 92 | −16.680 | 53.643 | 3.624 | 1.00 | 51.28 | | O |
| ANISOU | 3602 | O | GLY | B | 92 | 8637 | 6410 | 4436 | 79 | −3270 | −480 | O |
| ATOM | 3603 | N | CYS | B | 93 | −16.161 | 53.594 | 5.812 | 1.00 | 50.12 | | N |
| ANISOU | 3603 | N | CYS | B | 93 | 8076 | 6226 | 4740 | 122 | −3041 | −453 | N |
| ATOM | 3604 | CA | CYS | B | 93 | −15.301 | 52.425 | 5.726 | 1.00 | 55.92 | | C |
| ANISOU | 3604 | CA | CYS | B | 93 | 8952 | 6889 | 5407 | 137 | −2959 | −751 | C |
| ATOM | 3605 | C | CYS | B | 93 | −16.002 | 51.243 | 5.096 | 1.00 | 63.22 | | C |
| ANISOU | 3605 | C | CYS | B | 93 | 9929 | 7674 | 6416 | 58 | −3250 | −846 | C |
| ATOM | 3606 | O | CYS | B | 93 | −17.098 | 50.853 | 5.514 | 1.00 | 61.92 | | O |
| ANISOU | 3606 | O | CYS | B | 93 | 9525 | 7415 | 6585 | −42 | −3490 | −687 | O |
| ATOM | 3607 | CB | CYS | B | 93 | −14.790 | 52.019 | 7.109 | 1.00 | 48.97 | | C |
| ANISOU | 3607 | CB | CYS | B | 93 | 7798 | 5960 | 4849 | 144 | −2770 | −775 | C |
| ATOM | 3608 | SG | CYS | B | 93 | −13.394 | 50.914 | 7.014 | 1.00 | 79.27 | | S |
| ANISOU | 3608 | SG | CYS | B | 93 | 11814 | 9711 | 8594 | 219 | −2589 | −1140 | S |
| ATOM | 3609 | N | LYS | B | 94 | −15.358 | 50.673 | 4.088 | 1.00 | 63.15 | | N |
| ANISOU | 3609 | N | LYS | B | 94 | 10223 | 7661 | 6109 | 106 | −3204 | −1105 | N |
| ATOM | 3610 | CA | LYS | B | 94 | −15.909 | 49.513 | 3.429 | 1.00 | 70.85 | | C |
| ANISOU | 3610 | CA | LYS | B | 94 | 11292 | 8488 | 7139 | 53 | −3487 | −1239 | C |
| ATOM | 3611 | C | LYS | B | 94 | −14.862 | 48.398 | 3.445 | 1.00 | 69.91 | | C |
| ANISOU | 3611 | C | LYS | B | 94 | 11279 | 8268 | 7015 | 133 | −3359 | −1568 | C |
| ATOM | 3612 | O | LYS | B | 94 | −15.081 | 47.311 | 2.908 | 1.00 | 74.30 | | O |
| ANISOU | 3612 | O | LYS | B | 94 | 11943 | 8677 | 7613 | 121 | −3568 | −1740 | O |
| ATOM | 3613 | CB | LYS | B | 94 | −16.385 | 49.878 | 2.021 | 1.00 | 79.16 | | C |
| ANISOU | 3613 | CB | LYS | B | 94 | 12605 | 9630 | 7840 | 34 | −3632 | −1230 | C |
| ATOM | 3614 | CG | LYS | B | 94 | −17.697 | 50.691 | 2.052 | 1.00 | 83.70 | | C |
| ANISOU | 3614 | CG | LYS | B | 94 | 13009 | 10220 | 8572 | −58 | −3868 | −892 | C |
| ATOM | 3615 | CD | LYS | B | 94 | −18.742 | 50.198 | 1.041 | 1.00 | 89.82 | | C |
| ANISOU | 3615 | CD | LYS | B | 94 | 13904 | 10910 | 9316 | −143 | −4241 | −884 | C |
| ATOM | 3616 | CE | LYS | B | 94 | −20.170 | 50.321 | 1.594 | 1.00 | 88.61 | | C |
| ANISOU | 3616 | CE | LYS | B | 94 | 13420 | 10652 | 9594 | −251 | −4509 | −591 | C |
| ATOM | 3617 | NZ | LYS | B | 94 | −20.282 | 49.974 | 3.049 | 1.00 | 88.01 | | N |
| ANISOU | 3617 | NZ | LYS | B | 94 | 12980 | 10498 | 9960 | −280 | −4422 | −496 | N |
| ATOM | 3618 | N | ASN | B | 95 | −13.728 | 48.687 | 4.084 | 1.00 | 62.25 | | N |
| ANISOU | 3618 | N | ASN | B | 95 | 10263 | 7366 | 6024 | 224 | −3020 | −1651 | N |
| ATOM | 3619 | CA | ASN | B | 95 | −12.645 | 47.723 | 4.256 | 1.00 | 56.34 | | C |
| ANISOU | 3619 | CA | ASN | B | 95 | 9546 | 6517 | 5343 | 320 | −2857 | −1942 | C |
| ATOM | 3620 | C | ASN | B | 95 | −12.160 | 47.632 | 5.709 | 1.00 | 55.07 | | C |
| ANISOU | 3620 | C | ASN | B | 95 | 9114 | 6277 | 5532 | 324 | −2736 | −1877 | C |
| ATOM | 3621 | O | ASN | B | 95 | −10.951 | 47.646 | 5.965 | 1.00 | 50.27 | | O |
| ANISOU | 3621 | O | ASN | B | 95 | 8510 | 5705 | 4886 | 435 | −2424 | −2039 | O |
| ATOM | 3622 | CB | ASN | B | 95 | −11.455 | 48.073 | 3.352 | 1.00 | 58.90 | | C |
| ANISOU | 3622 | CB | ASN | B | 95 | 10104 | 7029 | 5247 | 449 | −2488 | −2168 | C |
| ATOM | 3623 | CG | ASN | B | 95 | −11.773 | 47.933 | 1.863 | 1.00 | 74.46 | | C |
| ANISOU | 3623 | CG | ASN | B | 95 | 12361 | 9090 | 6842 | 441 | −2597 | −2290 | C |
| ATOM | 3624 | OD1 | ASN | B | 95 | −11.492 | 48.833 | 1.067 | 1.00 | 77.32 | | O |
| ANISOU | 3624 | OD1 | ASN | B | 95 | 12887 | 9688 | 6804 | 454 | −2403 | −2249 | O |
| ATOM | 3625 | ND2 | ASN | B | 95 | −12.338 | 46.787 | 1.479 | 1.00 | 79.27 | | N |
| ANISOU | 3625 | ND2 | ASN | B | 95 | 13032 | 9511 | 7575 | 412 | −2914 | −2434 | N |
| ATOM | 3626 | N | CYS | B | 96 | −13.091 | 47.536 | 6.658 | 1.00 | 54.16 | | N |
| ANISOU | 3626 | N | CYS | B | 96 | 8740 | 6073 | 5765 | 195 | −2965 | −1627 | N |
| ATOM | 3627 | CA | CYS | B | 96 | −12.722 | 47.410 | 8.076 | 1.00 | 49.60 | | C |
| ANISOU | 3627 | CA | CYS | B | 96 | 7891 | 5440 | 5513 | 165 | −2880 | −1536 | C |
| ATOM | 3628 | C | CYS | B | 96 | −13.308 | 46.164 | 8.710 | 1.00 | 52.76 | | C |
| ANISOU | 3628 | C | CYS | B | 96 | 8103 | 5619 | 6326 | 48 | −3154 | −1445 | C |
| ATOM | 3629 | O | CYS | B | 96 | −14.060 | 45.424 | 8.073 | 1.00 | 48.48 | | O |
| ANISOU | 3629 | O | CYS | B | 96 | 7635 | 4947 | 5839 | −4 | −3422 | −1453 | O |
| ATOM | 3630 | CB | CYS | B | 96 | −13.169 | 48.631 | 8.886 | 1.00 | 45.84 | | C |
| ANISOU | 3630 | CB | CYS | B | 96 | 7201 | 5137 | 5078 | 111 | −2787 | −1248 | C |
| ATOM | 3631 | SG | CYS | B | 96 | −12.269 | 50.165 | 8.527 | 1.00 | 78.31 | | S |
| ANISOU | 3631 | SG | CYS | B | 96 | 11418 | 9492 | 8844 | 246 | −2307 | −1230 | S |
| ATOM | 3632 | N | GLY | B | 97 | −12.951 | 45.949 | 9.972 | 1.00 | 51.90 | | N |
| ANISOU | 3632 | N | GLY | B | 97 | 7753 | 5467 | 6502 | 1 | −3084 | −1339 | N |
| ATOM | 3633 | CA | GLY | B | 97 | −13.432 | 44.814 | 10.742 | 1.00 | 52.49 | | C |
| ANISOU | 3633 | CA | GLY | B | 97 | 7624 | 5348 | 6970 | −127 | −3298 | −1179 | C |
| ATOM | 3634 | C | GLY | B | 97 | −14.674 | 45.183 | 11.526 | 1.00 | 55.28 | | C |
| ANISOU | 3634 | C | GLY | B | 97 | 7688 | 5809 | 7507 | −301 | −3373 | −798 | C |
| ATOM | 3635 | O | GLY | B | 97 | −14.934 | 46.365 | 11.767 | 1.00 | 54.83 | | O |
| ANISOU | 3635 | O | GLY | B | 97 | 7530 | 5977 | 7326 | −299 | −3225 | −669 | O |
| ATOM | 3636 | N | VAL | B | 98 | −15.441 | 44.175 | 11.927 | 1.00 | 44.95 | | N |
| ANISOU | 3636 | N | VAL | B | 98 | 6239 | 4343 | 6499 | −436 | −3582 | −613 | N |
| ATOM | 3637 | CA | VAL | B | 98 | −16.613 | 44.400 | 12.757 | 1.00 | 44.64 | | C |
| ANISOU | 3637 | CA | VAL | B | 98 | 5895 | 4421 | 6644 | −601 | −3586 | −248 | C |
| ATOM | 3638 | C | VAL | B | 98 | −16.181 | 44.540 | 14.204 | 1.00 | 47.64 | | C |
| ANISOU | 3638 | C | VAL | B | 98 | 6029 | 4921 | 7151 | −660 | −3364 | −66 | C |
| ATOM | 3639 | O | VAL | B | 98 | −15.288 | 43.832 | 14.656 | 1.00 | 49.20 | | O |
| ANISOU | 3639 | O | VAL | B | 98 | 6258 | 4979 | 7457 | −644 | −3355 | −137 | O |
| ATOM | 3640 | CB | VAL | B | 98 | −17.634 | 43.257 | 12.645 | 1.00 | 54.97 | | C |
| ANISOU | 3640 | CB | VAL | B | 98 | 7156 | 5519 | 8213 | −740 | −3879 | −97 | C |
| ATOM | 3641 | CG1 | VAL | B | 98 | −18.855 | 43.575 | 13.494 | 1.00 | 55.67 | | C |
| ANISOU | 3641 | CG1 | VAL | B | 98 | 6916 | 5772 | 8462 | −902 | −3825 | 271 | C |
| ATOM | 3642 | CG2 | VAL | B | 98 | −18.042 | 43.026 | 11.190 | 1.00 | 50.92 | | C |
| ANISOU | 3642 | CG2 | VAL | B | 98 | 6907 | 4871 | 7570 | −684 | −4133 | −292 | C |
| ATOM | 3643 | N | HIS | B | 99 | −16.778 | 45.482 | 14.925 | 1.00 | 48.28 | | N |
| ANISOU | 3643 | N | HIS | B | 99 | 5866 | 5267 | 7210 | −709 | −3181 | 157 | N |
| ATOM | 3644 | CA | HIS | B | 99 | −16.424 | 45.679 | 16.325 | 1.00 | 39.58 | | C |
| ANISOU | 3644 | CA | HIS | B | 99 | 4539 | 4324 | 6177 | −762 | −2954 | 330 | C |
| ATOM | 3645 | C | HIS | B | 99 | −17.657 | 45.819 | 17.222 | 1.00 | 42.65 | | C |
| ANISOU | 3645 | C | HIS | B | 99 | 4618 | 4903 | 6682 | −900 | −2880 | 659 | C |
| ATOM | 3646 | O | HIS | B | 99 | −18.792 | 45.699 | 16.765 | 1.00 | 53.26 | | O |
| ANISOU | 3646 | O | HIS | B | 99 | 5902 | 6229 | 8106 | −962 | −3022 | 763 | O |
| ATOM | 3647 | CB | HIS | B | 99 | −15.515 | 46.893 | 16.460 | 1.00 | 36.32 | | C |
| ANISOU | 3647 | CB | HIS | B | 99 | 4152 | 4091 | 5555 | −623 | −2722 | 195 | C |
| ATOM | 3648 | CG | HIS | B | 99 | −14.360 | 46.890 | 15.501 | 1.00 | 44.90 | | C |
| ANISOU | 3648 | CG | HIS | B | 99 | 5545 | 5029 | 6487 | −476 | −2765 | −146 | C |
| ATOM | 3649 | ND1 | HIS | B | 99 | −13.293 | 46.024 | 15.617 | 1.00 | 46.58 | | N |
| ANISOU | 3649 | ND1 | HIS | B | 99 | 5864 | 5044 | 6789 | −448 | −2794 | −309 | N |
| ATOM | 3650 | CD2 | HIS | B | 99 | −14.100 | 47.659 | 14.416 | 1.00 | 47.23 | | C |
| ANISOU | 3650 | CD2 | HIS | B | 99 | 6071 | 5358 | 6517 | −327 | −2693 | −350 | C |
| ATOM | 3651 | CE1 | HIS | B | 99 | −12.432 | 46.254 | 14.641 | 1.00 | 43.23 | | C |
| ANISOU | 3651 | CE1 | HIS | B | 99 | 5707 | 4557 | 6160 | −278 | −2710 | −623 | C |
| ATOM | 3652 | NE2 | HIS | B | 99 | −12.899 | 47.240 | 13.898 | 1.00 | 44.73 | | N |
| ANISOU | 3652 | NE2 | HIS | B | 99 | 5989 | 4899 | 6107 | −210 | −2621 | −635 | N |
| ATOM | 3653 | N | MET | B | 100 | −17.412 | 46.044 | 18.507 | 1.00 | 46.02 | | N |
| ANISOU | 3653 | N | MET | B | 100 | 4854 | 5516 | 7115 | −948 | −2662 | 815 | N |
| ATOM | 3654 | CA | MET | B | 100 | −18.457 | 46.256 | 19.508 | 1.00 | 49.79 | | C |
| ANISOU | 3654 | CA | MET | B | 100 | 5031 | 6233 | 7655 | −1060 | −2534 | 1106 | C |
| ATOM | 3655 | C | MET | B | 100 | −19.425 | 47.347 | 19.065 | 1.00 | 48.30 | | C |
| ANISOU | 3655 | C | MET | B | 100 | 4709 | 6232 | 7412 | −980 | −2476 | 1119 | C |
| ATOM | 3656 | O | MET | B | 100 | −20.639 | 47.259 | 19.259 | 1.00 | 52.47 | | O |
| ANISOU | 3656 | O | MET | B | 100 | 5030 | 6847 | 8059 | −1067 | −2506 | 1317 | O |
| ATOM | 3657 | CB | MET | B | 100 | −17.817 | 46.646 | 20.851 | 1.00 | 51.52 | | C |
| ANISOU | 3657 | CB | MET | B | 100 | 5118 | 6674 | 7784 | −1071 | −2272 | 1194 | C |
| ATOM | 3658 | CG | MET | B | 100 | −17.262 | 45.489 | 21.665 | 1.00 | 55.60 | | C |
| ANISOU | 3658 | CG | MET | B | 100 | 5668 | 7057 | 8399 | −1205 | −2334 | 1327 | C |
| ATOM | 3659 | SD | MET | B | 100 | −16.547 | 46.049 | 23.224 | 1.00 | 56.92 | | S |
| ANISOU | 3659 | SD | MET | B | 100 | 5702 | 7518 | 8408 | −1227 | −2046 | 1436 | S |
| ATOM | 3660 | CE | MET | B | 100 | −17.991 | 46.814 | 23.957 | 1.00 | 40.13 | | C |
| ANISOU | 3660 | CE | MET | B | 100 | 3244 | 5789 | 6214 | −1280 | −1843 | 1671 | C |
| ATOM | 3661 | N | GLU | B | 101 | −18.867 | 48.383 | 18.457 | 1.00 | 44.56 | | N |
| ANISOU | 3661 | N | GLU | B | 101 | 4351 | 5806 | 6774 | −809 | −2407 | 918 | N |
| ATOM | 3662 | CA | GLU | B | 101 | −19.662 | 49.507 | 18.016 | 1.00 | 41.17 | | C |
| ANISOU | 3662 | CA | GLU | B | 101 | 3813 | 5524 | 6305 | −703 | −2369 | 930 | C |
| ATOM | 3663 | C | GLU | B | 101 | −19.574 | 49.664 | 16.512 | 1.00 | 39.30 | | C |
| ANISOU | 3663 | C | GLU | B | 101 | 3854 | 5103 | 5975 | −617 | −2585 | 749 | C |
| ATOM | 3664 | O | GLU | B | 101 | −18.610 | 49.226 | 15.899 | 1.00 | 43.19 | | O |
| ANISOU | 3664 | O | GLU | B | 101 | 4627 | 5416 | 6365 | −587 | −2679 | 554 | O |
| ATOM | 3665 | CB | GLU | B | 101 | −19.200 | 50.783 | 18.716 | 1.00 | 35.69 | | C |
| ANISOU | 3665 | CB | GLU | B | 101 | 2990 | 5074 | 5498 | −567 | −2092 | 906 | C |
| ATOM | 3666 | CG | GLU | B | 101 | −19.515 | 50.787 | 20.190 | 1.00 | 36.74 | | C |
| ANISOU | 3666 | CG | GLU | B | 101 | 2831 | 5455 | 5674 | −642 | −1856 | 1087 | C |
| ATOM | 3667 | CD | GLU | B | 101 | −18.392 | 50.194 | 21.007 | 1.00 | 43.50 | | C |
| ANISOU | 3667 | CD | GLU | B | 101 | 3771 | 6290 | 6467 | −719 | −1775 | 1074 | C |
| ATOM | 3668 | OE1 | GLU | B | 101 | −17.223 | 50.363 | 20.611 | 1.00 | 42.14 | | O |
| ANISOU | 3668 | OE1 | GLU | B | 101 | 3821 | 5993 | 6197 | −636 | −1784 | 885 | O |
| ATOM | 3669 | OE2 | GLU | B | 101 | −18.672 | 49.563 | 22.046 | 1.00 | 54.29 | | O |
| ANISOU | 3669 | OE2 | GLU | B | 101 | 4993 | 7760 | 7877 | −862 | −1702 | 1261 | O |
| ATOM | 3670 | N | ASN | B | 102 | −20.595 | 50.274 | 15.921 | 1.00 | 45.92 | | N |
| ANISOU | 3670 | N | ASN | B | 102 | 4614 | 5991 | 6843 | −575 | −2666 | 812 | N |
| ATOM | 3671 | CA | ASN | B | 102 | −20.554 | 50.648 | 14.516 | 1.00 | 49.75 | | C |
| ANISOU | 3671 | CA | ASN | B | 102 | 5369 | 6349 | 7183 | −487 | −2854 | 668 | C |
| ATOM | 3672 | C | ASN | B | 102 | −19.458 | 51.694 | 14.313 | 1.00 | 50.91 | | C |
| ANISOU | 3672 | C | ASN | B | 102 | 5690 | 6549 | 7103 | −319 | −2718 | 516 | C |
| ATOM | 3673 | O | ASN | B | 102 | −19.104 | 52.398 | 15.258 | 1.00 | 45.51 | | O |
| ANISOU | 3673 | O | ASN | B | 102 | 4845 | 6022 | 6425 | −249 | −2452 | 553 | O |
| ATOM | 3674 | CB | ASN | B | 102 | −21.908 | 51.201 | 14.059 | 1.00 | 57.46 | | C |
| ANISOU | 3674 | CB | ASN | B | 102 | 6189 | 7380 | 8264 | −475 | −2963 | 805 | C |
| ATOM | 3675 | CG | ASN | B | 102 | −23.043 | 50.210 | 14.238 | 1.00 | 62.14 | | C |
| ANISOU | 3675 | CG | ASN | B | 102 | 6601 | 7913 | 9097 | −647 | −3114 | 973 | C |
| ATOM | 3676 | OD1 | ASN | B | 102 | −22.923 | 49.033 | 13.903 | 1.00 | 62.33 | | O |
| ANISOU | 3676 | OD1 | ASN | B | 102 | 6782 | 7735 | 9165 | −766 | −3301 | 934 | O |
| ATOM | 3677 | ND2 | ASN | B | 102 | −24.160 | 50.692 | 14.769 | 1.00 | 65.60 | | N |
| ANISOU | 3677 | ND2 | ASN | B | 102 | 6701 | 8514 | 9710 | −652 | −3040 | 1162 | N |
| ATOM | 3678 | N | PRO | B | 103 | −18.909 | 51.789 | 13.086 | 1.00 | 51.01 | | N |
| ANISOU | 3678 | N | PRO | B | 103 | 6060 | 6435 | 6888 | −251 | −2854 | 335 | N |
| ATOM | 3679 | CA | PRO | B | 103 | −17.919 | 52.827 | 12.769 | 1.00 | 45.46 | | C |
| ANISOU | 3679 | CA | PRO | B | 103 | 5573 | 5772 | 5926 | −89 | −2590 | 198 | C |
| ATOM | 3680 | C | PRO | B | 103 | −18.402 | 54.221 | 13.148 | 1.00 | 47.88 | | C |
| ANISOU | 3680 | C | PRO | B | 103 | 5691 | 6221 | 6280 | 23 | −2404 | 329 | C |
| ATOM | 3681 | O | PRO | B | 103 | −19.594 | 54.500 | 13.084 | 1.00 | 52.51 | | O |
| ANISOU | 3681 | O | PRO | B | 103 | 6066 | 6853 | 7034 | 9 | −2582 | 494 | O |
| ATOM | 3682 | CB | PRO | B | 103 | −17.755 | 52.702 | 11.251 | 1.00 | 44.47 | | C |
| ANISOU | 3682 | CB | PRO | B | 103 | 5820 | 5531 | 5545 | −65 | −2811 | 56 | C |
| ATOM | 3683 | CG | PRO | B | 103 | −18.091 | 51.267 | 10.966 | 1.00 | 39.96 | | C |
| ANISOU | 3683 | CG | PRO | B | 103 | 5296 | 4807 | 5082 | −199 | −3105 | −3 | C |
| ATOM | 3684 | CD | PRO | B | 103 | −19.171 | 50.901 | 11.934 | 1.00 | 41.68 | | C |
| ANISOU | 3684 | CD | PRO | B | 103 | 5125 | 5068 | 5645 | −317 | −3116 | 232 | C |
| ATOM | 3685 | N | PHE | B | 104 | −17.489 | 55.081 | 13.569 | 1.00 | 44.36 | | N |
| ANISOU | 3685 | N | PHE | B | 104 | 5302 | 5829 | 5726 | 136 | −2065 | 252 | N |
| ATOM | 3686 | CA | PHE | B | 104 | −17.884 | 56.419 | 13.970 | 1.00 | 43.57 | | C |
| ANISOU | 3686 | CA | PHE | B | 104 | 5037 | 5820 | 5697 | 260 | −1901 | 339 | C |
| ATOM | 3687 | C | PHE | B | 104 | −18.477 | 57.157 | 12.785 | 1.00 | 46.01 | | C |
| ANISOU | 3687 | C | PHE | B | 104 | 5475 | 6067 | 5941 | 320 | −2110 | 409 | C |
| ATOM | 3688 | O | PHE | B | 104 | −17.871 | 57.213 | 11.716 | 1.00 | 50.65 | | O |
| ANISOU | 3688 | O | PHE | B | 104 | 6393 | 6573 | 6278 | 323 | −2170 | 334 | O |
| ATOM | 3689 | CB | PHE | B | 104 | −16.704 | 57.210 | 14.530 | 1.00 | 31.28 | | C |
| ANISOU | 3689 | CB | PHE | B | 104 | 3563 | 4286 | 4038 | 356 | −1549 | 228 | C |
| ATOM | 3690 | CG | PHE | B | 104 | −17.073 | 58.606 | 14.949 | 1.00 | 38.30 | | C |
| ANISOU | 3690 | CG | PHE | B | 104 | 4306 | 5223 | 5024 | 496 | −1406 | 279 | C |
| ATOM | 3691 | CD1 | PHE | B | 104 | −17.738 | 58.824 | 16.152 | 1.00 | 36.05 | | C |
| ANISOU | 3691 | CD1 | PHE | B | 104 | 3690 | 5076 | 4932 | 535 | −1288 | 325 | C |
| ATOM | 3692 | CD2 | PHE | B | 104 | −16.788 | 59.695 | 14.134 | 1.00 | 32.76 | | C |
| ANISOU | 3692 | CD2 | PHE | B | 104 | 3794 | 4429 | 4225 | 590 | −1399 | 283 | C |
| ATOM | 3693 | CE1 | PHE | B | 104 | −18.093 | 60.094 | 16.545 | 1.00 | 37.94 | | C |
| ANISOU | 3693 | CE1 | PHE | B | 104 | 3795 | 5340 | 5279 | 695 | −1162 | 323 | C |
| ATOM | 3694 | CE2 | PHE | B | 104 | −17.135 | 60.976 | 14.524 | 1.00 | 33.68 | | C |
| ANISOU | 3694 | CE2 | PHE | B | 104 | 3776 | 4537 | 4482 | 730 | −1306 | 320 | C |
| ATOM | 3695 | CZ | PHE | B | 104 | −17.794 | 61.180 | 15.724 | 1.00 | 37.64 | | C |
| ANISOU | 3695 | CZ | PHE | B | 104 | 3952 | 5157 | 5193 | 798 | −1190 | 314 | C |
| ATOM | 3696 | N | ASN | B | 105 | −19.661 | 57.725 | 12.968 | 1.00 | 48.62 | | N |
| ANISOU | 3696 | N | ASN | B | 105 | 5535 | 6445 | 6492 | 369 | −2220 | 562 | N |
| ATOM | 3697 | CA | ASN | B | 105 | −20.338 | 58.397 | 11.863 | 1.00 | 50.35 | | C |
| ANISOU | 3697 | CA | ASN | B | 105 | 5847 | 6588 | 6695 | 417 | −2483 | 668 | C |
| ATOM | 3698 | C | ASN | B | 105 | −20.098 | 59.901 | 11.878 | 1.00 | 44.28 | | C |
| ANISOU | 3698 | C | ASN | B | 105 | 5101 | 5791 | 5933 | 582 | −2310 | 691 | C |
| ATOM | 3699 | O | ASN | B | 105 | −20.675 | 60.611 | 12.699 | 1.00 | 45.72 | | O |
| ANISOU | 3699 | O | ASN | B | 105 | 4978 | 6025 | 6367 | 698 | −2196 | 735 | O |
| ATOM | 3700 | CB | ASN | B | 105 | −21.842 | 58.101 | 11.894 | 1.00 | 55.10 | | C |
| ANISOU | 3700 | CB | ASN | B | 105 | 6124 | 7223 | 7590 | 373 | −2780 | 843 | C |
| ATOM | 3701 | CG | ASN | B | 105 | −22.529 | 58.436 | 10.585 | 1.00 | 54.06 | | C |
| ANISOU | 3701 | CG | ASN | B | 105 | 6152 | 6988 | 7399 | 364 | −3081 | 933 | C |
| ATOM | 3702 | OD1 | ASN | B | 105 | −22.210 | 59.441 | 9.947 | 1.00 | 60.71 | | O |
| ANISOU | 3702 | OD1 | ASN | B | 105 | 7189 | 7766 | 8114 | 464 | −3113 | 966 | O |
| ATOM | 3703 | ND2 | ASN | B | 105 | −23.456 | 57.579 | 10.162 | 1.00 | 51.84 | | N |
| ANISOU | 3703 | ND2 | ASN | B | 105 | 5815 | 6681 | 7202 | 229 | −3279 | 976 | N |
| ATOM | 3704 | N | LEU | B | 106 | −19.254 | 60.379 | 10.966 | 1.00 | 40.63 | | N |
| ANISOU | 3704 | N | LEU | B | 106 | 4994 | 5245 | 5201 | 593 | −2292 | 659 | N |
| ATOM | 3705 | CA | LEU | B | 106 | −18.908 | 61.792 | 10.945 | 1.00 | 44.36 | | C |
| ANISOU | 3705 | CA | LEU | B | 106 | 5513 | 5650 | 5694 | 721 | −2151 | 703 | C |
| ATOM | 3706 | C | LEU | B | 106 | −20.101 | 62.679 | 10.617 | 1.00 | 51.73 | | C |
| ANISOU | 3706 | C | LEU | B | 106 | 6277 | 6513 | 6866 | 820 | −2401 | 883 | C |
| ATOM | 3707 | O | LEU | B | 106 | −20.215 | 63.772 | 11.162 | 1.00 | 56.30 | | O |
| ANISOU | 3707 | O | LEU | B | 106 | 6700 | 7038 | 7655 | 967 | −2279 | 899 | O |
| ATOM | 3708 | CB | LEU | B | 106 | −17.782 | 62.072 | 9.949 | 1.00 | 45.44 | | C |
| ANISOU | 3708 | CB | LEU | B | 106 | 6052 | 5730 | 5482 | 675 | −2091 | 687 | C |
| ATOM | 3709 | CG | LEU | B | 106 | −16.407 | 61.486 | 10.275 | 1.00 | 48.39 | | C |
| ANISOU | 3709 | CG | LEU | B | 106 | 6573 | 6153 | 5659 | 620 | −1791 | 504 | C |
| ATOM | 3710 | CD1 | LEU | B | 106 | −15.931 | 60.518 | 9.197 | 1.00 | 51.68 | | C |
| ANISOU | 3710 | CD1 | LEU | B | 106 | 7301 | 6595 | 5739 | 515 | −1892 | 427 | C |
| ATOM | 3711 | CD2 | LEU | B | 106 | −15.422 | 62.590 | 10.444 | 1.00 | 35.68 | | C |
| ANISOU | 3711 | CD2 | LEU | B | 106 | 5047 | 4491 | 4019 | 676 | −1534 | 508 | C |
| ATOM | 3712 | N | ASN | B | 107 | −20.995 | 62.214 | 9.747 | 1.00 | 54.59 | | N |
| ANISOU | 3712 | N | ASN | B | 107 | 6661 | 6858 | 7223 | 748 | −2774 | 1008 | N |
| ATOM | 3713 | CA | ASN | B | 107 | −22.118 | 63.055 | 9.316 | 1.00 | 53.12 | | C |
| ANISOU | 3713 | CA | ASN | B | 107 | 6316 | 6584 | 7282 | 840 | −3065 | 1204 | C |
| ATOM | 3714 | C | ASN | B | 107 | −23.087 | 63.325 | 10.463 | 1.00 | 49.89 | | C |
| ANISOU | 3714 | C | ASN | B | 107 | 5412 | 6237 | 7309 | 971 | −2965 | 1205 | C |
| ATOM | 3715 | O | ASN | B | 107 | −23.762 | 64.346 | 10.478 | 1.00 | 60.03 | | O |
| ANISOU | 3715 | O | ASN | B | 107 | 6529 | 7445 | 8834 | 1108 | −2991 | 1277 | O |
| ATOM | 3716 | CB | ASN | B | 107 | −22.860 | 62.420 | 8.129 | 1.00 | 57.14 | | C |
| ANISOU | 3716 | CB | ASN | B | 107 | 6970 | 7082 | 7657 | 689 | −3373 | 1281 | C |
| ATOM | 3717 | CG | ASN | B | 107 | −22.289 | 62.841 | 6.772 | 1.00 | 67.66 | | C |
| ANISOU | 3717 | CG | ASN | B | 107 | 8746 | 8343 | 8618 | 628 | −3508 | 1354 | C |
| ATOM | 3718 | OD1 | ASN | B | 107 | −21.709 | 63.918 | 6.637 | 1.00 | 79.53 | | O |
| ANISOU | 3718 | OD1 | ASN | B | 107 | 10379 | 9770 | 10070 | 710 | −3435 | 1439 | O |
| ATOM | 3719 | ND2 | ASN | B | 107 | −22.456 | 61.986 | 5.763 | 1.00 | 65.17 | | N |
| ANISOU | 3719 | ND2 | ASN | B | 107 | 8664 | 8053 | 8044 | 477 | −3697 | 1324 | N |
| ATOM | 3720 | N | ASN | B | 108 | −23.116 | 62.434 | 11.448 | 1.00 | 49.81 | | N |
| ANISOU | 3720 | N | ASN | B | 108 | 5180 | 6377 | 7369 | 920 | −2788 | 1104 | N |
| ATOM | 3721 | CA | ASN | B | 108 | −24.027 | 62.572 | 12.579 | 1.00 | 50.21 | | C |
| ANISOU | 3721 | CA | ASN | B | 108 | 4756 | 6554 | 7767 | 1023 | −2636 | 1101 | C |
| ATOM | 3722 | C | ASN | B | 108 | −23.445 | 63.379 | 13.722 | 1.00 | 51.58 | | C |
| ANISOU | 3722 | C | ASN | B | 108 | 4820 | 6771 | 8007 | 1192 | −2249 | 944 | C |
| ATOM | 3723 | O | ASN | B | 108 | −24.130 | 63.670 | 14.698 | 1.00 | 58.28 | | O |
| ANISOU | 3723 | O | ASN | B | 108 | 5285 | 7743 | 9117 | 1322 | −2089 | 910 | O |
| ATOM | 3724 | CB | ASN | B | 108 | −24.458 | 61.200 | 13.082 | 1.00 | 46.39 | | C |
| ANISOU | 3724 | CB | ASN | B | 108 | 4094 | 6232 | 7298 | 847 | −2612 | 1100 | C |
| ATOM | 3725 | CG | ASN | B | 108 | −25.331 | 60.478 | 12.085 | 1.00 | 48.86 | | C |
| ANISOU | 3725 | CG | ASN | B | 108 | 4483 | 6489 | 7591 | 684 | −2914 | 1200 | C |
| ATOM | 3726 | OD1 | ASN | B | 108 | −25.914 | 61.098 | 11.195 | 1.00 | 51.25 | | O |
| ANISOU | 3726 | OD1 | ASN | B | 108 | 4857 | 6682 | 7935 | 724 | −3119 | 1287 | O |
| ATOM | 3727 | ND2 | ASN | B | 108 | −25.425 | 59.167 | 12.223 | 1.00 | 48.60 | | N |
| ANISOU | 3727 | ND2 | ASN | B | 108 | 4444 | 6510 | 7513 | 494 | −2958 | 1191 | N |
| ATOM | 3728 | N | SER | B | 109 | −22.166 | 63.707 | 13.620 | 1.00 | 42.77 | | N |
| ANISOU | 3728 | N | SER | B | 109 | 4045 | 5572 | 6633 | 1180 | −2074 | 831 | N |
| ATOM | 3729 | CA | SER | B | 109 | −21.556 | 64.596 | 14.588 | 1.00 | 41.66 | | C |
| ANISOU | 3729 | CA | SER | B | 109 | 3861 | 5426 | 6542 | 1328 | −1748 | 670 | C |
| ATOM | 3730 | C | SER | B | 109 | −21.423 | 66.005 | 14.021 | 1.00 | 45.39 | | C |
| ANISOU | 3730 | C | SER | B | 109 | 4466 | 5667 | 7113 | 1476 | −1837 | 711 | C |
| ATOM | 3731 | O | SER | B | 109 | −20.667 | 66.242 | 13.072 | 1.00 | 49.15 | | O |
| ANISOU | 3731 | O | SER | B | 109 | 5293 | 6005 | 7376 | 1393 | −1934 | 784 | O |
| ATOM | 3732 | CB | SER | B | 109 | −20.197 | 64.066 | 15.017 | 1.00 | 38.51 | | C |
| ANISOU | 3732 | CB | SER | B | 109 | 3697 | 5076 | 5860 | 1212 | −1496 | 526 | C |
| ATOM | 3733 | OG | SER | B | 109 | −19.570 | 65.002 | 15.859 | 1.00 | 48.54 | | O |
| ANISOU | 3733 | OG | SER | B | 109 | 4960 | 6309 | 7175 | 1343 | −1236 | 374 | O |
| ATOM | 3734 | N | LYS | B | 110 | −22.163 | 66.939 | 14.605 | 1.00 | 45.16 | | N |
| ANISOU | 3734 | N | LYS | B | 110 | 4149 | 5597 | 7415 | 1697 | −1803 | 669 | N |
| ATOM | 3735 | CA | LYS | B | 110 | −22.187 | 68.316 | 14.120 | 1.00 | 47.19 | | C |
| ANISOU | 3735 | CA | LYS | B | 110 | 4486 | 5587 | 7855 | 1856 | −1940 | 723 | C |
| ATOM | 3736 | C | LYS | B | 110 | −20.859 | 69.027 | 14.362 | 1.00 | 46.07 | | C |
| ANISOU | 3736 | C | LYS | B | 110 | 4622 | 5308 | 7576 | 1858 | −1737 | 601 | C |
| ATOM | 3737 | O | LYS | B | 110 | −20.627 | 70.115 | 13.844 | 1.00 | 51.78 | | O |
| ANISOU | 3737 | O | LYS | B | 110 | 5490 | 5777 | 8408 | 1930 | −1866 | 681 | O |
| ATOM | 3738 | CB | LYS | B | 110 | −23.335 | 69.094 | 14.770 | 1.00 | 54.38 | | C |
| ANISOU | 3738 | CB | LYS | B | 110 | 4993 | 6482 | 9187 | 2117 | −1933 | 660 | C |
| ATOM | 3739 | CG | LYS | B | 110 | −23.171 | 69.302 | 16.264 | 1.00 | 63.48 | | C |
| ANISOU | 3739 | CG | LYS | B | 110 | 5929 | 7777 | 10412 | 2269 | −1555 | 373 | C |
| ATOM | 3740 | CD | LYS | B | 110 | −24.485 | 69.097 | 17.007 | 1.00 | 71.89 | | C |
| ANISOU | 3740 | CD | LYS | B | 110 | 6585 | 9091 | 11641 | 2361 | −1416 | 332 | C |
| ATOM | 3741 | CE | LYS | B | 110 | −25.559 | 70.064 | 16.550 | 1.00 | 78.04 | | C |
| ANISOU | 3741 | CE | LYS | B | 110 | 7240 | 9725 | 12688 | 2512 | −1577 | 409 | C |
| ATOM | 3742 | NZ | LYS | B | 110 | −26.835 | 69.836 | 17.287 | 1.00 | 83.28 | | N |
| ANISOU | 3742 | NZ | LYS | B | 110 | 7485 | 10656 | 13503 | 2613 | −1427 | 369 | N |
| ATOM | 3743 | N | THR | B | 111 | −19.995 | 68.425 | 15.168 | 1.00 | 42.66 | | N |
| ANISOU | 3743 | N | THR | B | 111 | 4248 | 5028 | 6933 | 1770 | −1445 | 428 | N |
| ATOM | 3744 | CA | THR | B | 111 | −18.738 | 69.071 | 15.509 | 1.00 | 42.46 | | C |
| ANISOU | 3744 | CA | THR | B | 111 | 4440 | 4878 | 6814 | 1765 | −1260 | 306 | C |
| ATOM | 3745 | C | THR | B | 111 | −17.544 | 68.370 | 14.863 | 1.00 | 41.20 | | C |
| ANISOU | 3745 | C | THR | B | 111 | 4608 | 4748 | 6299 | 1532 | −1213 | 371 | C |
| ATOM | 3746 | O | THR | B | 111 | −16.390 | 68.746 | 15.084 | 1.00 | 42.13 | | O |
| ANISOU | 3746 | O | THR | B | 111 | 4898 | 4786 | 6325 | 1486 | −1056 | 296 | O |
| ATOM | 3747 | CB | THR | B | 111 | −18.552 | 69.141 | 17.031 | 1.00 | 40.45 | | C |
| ANISOU | 3747 | CB | THR | B | 111 | 4001 | 4751 | 6616 | 1872 | −962 | 33 | C |
| ATOM | 3748 | OG1 | THR | B | 111 | −18.954 | 67.901 | 17.620 | 1.00 | 39.31 | | O |
| ANISOU | 3748 | OG1 | THR | B | 111 | 3675 | 4905 | 6356 | 1786 | −849 | 2 | O |
| ATOM | 3749 | CG2 | THR | B | 111 | −19.410 | 70.257 | 17.609 | 1.00 | 43.46 | | C |
| ANISOU | 3749 | CG2 | THR | B | 111 | 4132 | 5029 | 7353 | 2153 | −971 | −91 | C |
| ATOM | 3750 | N | SER | B | 112 | −17.825 | 67.377 | 14.032 | 1.00 | 38.63 | | N |
| ANISOU | 3750 | N | SER | B | 112 | 4362 | 4525 | 5791 | 1391 | −1363 | 501 | N |
| ATOM | 3751 | CA | SER | B | 112 | −16.766 | 66.694 | 13.305 | 1.00 | 37.04 | | C |
| ANISOU | 3751 | CA | SER | B | 112 | 4467 | 4356 | 5251 | 1202 | −1323 | 536 | C |
| ATOM | 3752 | C | SER | B | 112 | −16.214 | 67.617 | 12.230 | 1.00 | 43.35 | | C |
| ANISOU | 3752 | C | SER | B | 112 | 5539 | 4973 | 5961 | 1167 | −1425 | 703 | C |
| ATOM | 3753 | O | SER | B | 112 | −16.950 | 68.375 | 11.607 | 1.00 | 41.02 | | O |
| ANISOU | 3753 | O | SER | B | 112 | 5237 | 4541 | 5807 | 1236 | −1667 | 871 | O |
| ATOM | 3754 | CB | SER | B | 112 | −17.290 | 65.408 | 12.680 | 1.00 | 37.08 | | C |
| ANISOU | 3754 | CB | SER | B | 112 | 4497 | 4495 | 5095 | 1080 | −1491 | 596 | C |
| ATOM | 3755 | OG | SER | B | 112 | −18.189 | 65.707 | 11.630 | 1.00 | 45.08 | | O |
| ANISOU | 3755 | OG | SER | B | 112 | 5551 | 5429 | 6147 | 1091 | −1815 | 790 | O |
| ATOM | 3756 | N | SER | B | 113 | −14.912 | 67.548 | 12.009 | 1.00 | 40.65 | | N |
| ANISOU | 3756 | N | SER | B | 113 | 5419 | 4631 | 5395 | 1053 | −1246 | 680 | N |
| ATOM | 3757 | CA | SER | B | 113 | −14.287 | 68.407 | 11.023 | 1.00 | 38.85 | | C |
| ANISOU | 3757 | CA | SER | B | 113 | 5438 | 4263 | 5058 | 986 | −1302 | 872 | C |
| ATOM | 3758 | C | SER | B | 113 | −13.124 | 67.675 | 10.362 | 1.00 | 39.85 | | C |
| ANISOU | 3758 | C | SER | B | 113 | 5811 | 4518 | 4812 | 818 | −1139 | 870 | C |
| ATOM | 3759 | O | SER | B | 113 | −12.067 | 67.506 | 10.970 | 1.00 | 38.31 | | O |
| ANISOU | 3759 | O | SER | B | 113 | 5607 | 4355 | 4592 | 780 | −882 | 736 | O |
| ATOM | 3760 | CB | SER | B | 113 | −13.819 | 69.709 | 11.690 | 1.00 | 39.93 | | C |
| ANISOU | 3760 | CB | SER | B | 113 | 5516 | 4190 | 5464 | 1071 | −1213 | 853 | C |
| ATOM | 3761 | OG | SER | B | 113 | −13.127 | 70.552 | 10.786 | 1.00 | 41.08 | | O |
| ANISOU | 3761 | OG | SER | B | 113 | 5888 | 4192 | 5529 | 972 | −1260 | 1079 | O |
| ATOM | 3762 | N | ILE | B | 114 | −13.328 | 67.226 | 9.125 | 1.00 | 40.05 | | N |
| ANISOU | 3762 | N | ILE | B | 114 | 6048 | 4622 | 4548 | 727 | −1295 | 1003 | N |
| ATOM | 3763 | CA | ILE | B | 114 | −12.277 | 66.541 | 8.369 | 1.00 | 40.33 | | C |
| ANISOU | 3763 | CA | ILE | B | 114 | 6325 | 4800 | 4198 | 593 | −1130 | 978 | C |
| ATOM | 3764 | C | ILE | B | 114 | −11.101 | 67.476 | 8.045 | 1.00 | 46.91 | | C |
| ANISOU | 3764 | C | ILE | B | 114 | 7290 | 5572 | 4960 | 515 | −940 | 1117 | C |
| ATOM | 3765 | O | ILE | B | 114 | −11.306 | 68.629 | 7.637 | 1.00 | 47.02 | | O |
| ANISOU | 3765 | O | ILE | B | 114 | 7359 | 5435 | 5071 | 508 | −1078 | 1356 | O |
| ATOM | 3766 | CB | ILE | B | 114 | −12.839 | 65.941 | 7.052 | 1.00 | 44.62 | | C |
| ANISOU | 3766 | CB | ILE | B | 114 | 7098 | 5448 | 4406 | 522 | −1368 | 1076 | C |
| ATOM | 3767 | CG1 | ILE | B | 114 | −13.803 | 64.788 | 7.340 | 1.00 | 40.97 | | C |
| ANISOU | 3767 | CG1 | ILE | B | 114 | 6511 | 5053 | 4003 | 557 | −1545 | 923 | C |
| ATOM | 3768 | CG2 | ILE | B | 114 | −11.727 | 65.453 | 6.147 | 1.00 | 42.74 | | C |
| ANISOU | 3768 | CG2 | ILE | B | 114 | 7136 | 5367 | 3736 | 408 | −1173 | 1050 | C |
| ATOM | 3769 | CD1 | ILE | B | 114 | −14.316 | 64.108 | 6.086 | 1.00 | 43.46 | | C |
| ANISOU | 3769 | CD1 | ILE | B | 114 | 7070 | 5455 | 3990 | 480 | −1812 | 973 | C |
| ATOM | 3770 | N | LEU | B | 115 | −9.877 | 66.973 | 8.212 | 1.00 | 40.57 | | N |
| ANISOU | 3770 | N | LEU | B | 115 | 6877 | 4357 | 4180 | 1240 | −1074 | 560 | N |
| ATOM | 3771 | CA | LEU | B | 115 | −8.679 | 67.757 | 7.934 | 1.00 | 36.54 | | C |
| ANISOU | 3771 | CA | LEU | B | 115 | 6592 | 3642 | 3648 | 1167 | −814 | 671 | C |
| ATOM | 3772 | C | LEU | B | 115 | −8.256 | 67.645 | 6.476 | 1.00 | 41.15 | | C |
| ANISOU | 3772 | C | LEU | B | 115 | 7493 | 4206 | 3938 | 1198 | −770 | 800 | C |
| ATOM | 3773 | O | LEU | B | 115 | −7.704 | 66.626 | 6.052 | 1.00 | 43.62 | | O |
| ANISOU | 3773 | O | LEU | B | 115 | 7821 | 4621 | 4130 | 1098 | −708 | 737 | O |
| ATOM | 3774 | CB | LEU | B | 115 | −7.541 | 67.319 | 8.854 | 1.00 | 35.14 | | C |
| ANISOU | 3774 | CB | LEU | B | 115 | 6245 | 3473 | 3635 | 944 | −597 | 566 | C |
| ATOM | 3775 | CG | LEU | B | 115 | −6.211 | 68.073 | 8.716 | 1.00 | 43.52 | | C |
| ANISOU | 3775 | CG | LEU | B | 115 | 7456 | 4353 | 4725 | 813 | −315 | 655 | C |
| ATOM | 3776 | CD1 | LEU | B | 115 | −6.348 | 69.577 | 8.935 | 1.00 | 34.62 | | C |
| ANISOU | 3776 | CD1 | LEU | B | 115 | 6461 | 2986 | 3708 | 869 | −267 | 743 | C |
| ATOM | 3777 | CD2 | LEU | B | 115 | −5.161 | 67.486 | 9.667 | 1.00 | 33.69 | | C |
| ANISOU | 3777 | CD2 | LEU | B | 115 | 5975 | 3186 | 3640 | 610 | −154 | 534 | C |
| ATOM | 3778 | N | TYR | B | 116 | −8.499 | 68.720 | 5.727 | 1.00 | 39.19 | | N |
| ANISOU | 3778 | N | TYR | B | 116 | 7513 | 3810 | 3567 | 1351 | −785 | 988 | N |
| ATOM | 3779 | CA | TYR | B | 116 | −8.265 | 68.789 | 4.283 | 1.00 | 41.84 | | C |
| ANISOU | 3779 | CA | TYR | B | 116 | 8193 | 4135 | 3571 | 1426 | −760 | 1152 | C |
| ATOM | 3780 | C | TYR | B | 116 | −6.920 | 69.424 | 3.913 | 1.00 | 42.92 | | C |
| ANISOU | 3780 | C | TYR | B | 116 | 8555 | 4076 | 3675 | 1294 | −407 | 1300 | C |
| ATOM | 3781 | O | TYR | B | 116 | −6.263 | 70.051 | 4.741 | 1.00 | 49.41 | | O |
| ANISOU | 3781 | O | TYR | B | 116 | 9287 | 4735 | 4751 | 1157 | −214 | 1293 | O |
| ATOM | 3782 | CB | TYR | B | 116 | −9.400 | 69.574 | 3.600 | 1.00 | 44.86 | | C |
| ANISOU | 3782 | CB | TYR | B | 116 | 8691 | 4514 | 3840 | 1669 | −983 | 1280 | C |
| ATOM | 3783 | CG | TYR | B | 116 | −10.740 | 68.860 | 3.566 | 1.00 | 47.63 | | C |
| ANISOU | 3783 | CG | TYR | B | 116 | 8810 | 5121 | 4167 | 1777 | −1328 | 1143 | C |
| ATOM | 3784 | CD1 | TYR | B | 116 | −10.970 | 67.815 | 2.676 | 1.00 | 45.69 | | C |
| ANISOU | 3784 | CD1 | TYR | B | 116 | 8590 | 5087 | 3681 | 1748 | −1465 | 1055 | C |
| ATOM | 3785 | CD2 | TYR | B | 116 | −11.783 | 69.246 | 4.405 | 1.00 | 45.57 | | C |
| ANISOU | 3785 | CD2 | TYR | B | 116 | 8291 | 4890 | 4133 | 1893 | −1499 | 1090 | C |
| ATOM | 3786 | CE1 | TYR | B | 116 | −12.184 | 67.163 | 2.632 | 1.00 | 46.17 | | C |
| ANISOU | 3786 | CE1 | TYR | B | 116 | 8418 | 5374 | 3752 | 1795 | −1768 | 921 | C |
| ATOM | 3787 | CE2 | TYR | B | 116 | −13.005 | 68.594 | 4.369 | 1.00 | 46.82 | | C |
| ANISOU | 3787 | CE2 | TYR | B | 116 | 8192 | 5300 | 4296 | 1954 | −1782 | 971 | C |
| ATOM | 3788 | CZ | TYR | B | 116 | −13.197 | 67.552 | 3.480 | 1.00 | 54.72 | | C |
| ANISOU | 3788 | CZ | TYR | B | 116 | 9215 | 6498 | 5077 | 1888 | −1919 | 889 | C |
| ATOM | 3789 | OH | TYR | B | 116 | −14.407 | 66.894 | 3.435 | 1.00 | 58.96 | | O |
| ANISOU | 3789 | OH | TYR | B | 116 | 9482 | 7274 | 5644 | 1902 | −2191 | 765 | O |
| ATOM | 3790 | O | CYS | B | 117 | −4.204 | 69.994 | 0.029 | 1.00 | 69.13 | | O |
| ANISOU | 3790 | O | CYS | B | 117 | 12708 | 7346 | 6213 | 1151 | 363 | 1777 | O |
| ATOM | 3791 | N | CYS | B | 117 | −6.516 | 69.254 | 2.659 | 1.00 | 45.14 | | N |
| ANISOU | 3791 | N | CYS | B | 117 | 9123 | 4391 | 3636 | 1322 | −321 | 1425 | N |
| ATOM | 3792 | CA | CYS | B | 117 | −5.255 | 69.808 | 2.178 | 1.00 | 46.74 | | C |
| ANISOU | 3792 | CA | CYS | B | 117 | 9504 | 4452 | 3802 | 1181 | 41 | 1571 | C |
| ATOM | 3793 | C | CYS | B | 117 | −5.253 | 69.987 | 0.663 | 1.00 | 59.23 | | C |
| ANISOU | 3793 | C | CYS | B | 117 | 11326 | 6106 | 5073 | 1263 | 74 | 1696 | C |
| ATOM | 3794 | CB | CYS | B | 117 | −4.085 | 68.925 | 2.622 | 1.00 | 44.54 | | C |
| ANISOU | 3794 | CB | CYS | B | 117 | 9049 | 4256 | 3618 | 963 | 279 | 1433 | C |
| ATOM | 3795 | SG | CYS | B | 117 | −4.234 | 67.164 | 2.156 | 1.00 | 57.47 | | S |
| ANISOU | 3795 | SG | CYS | B | 117 | 10613 | 6184 | 5037 | 993 | 153 | 1220 | S |
| ATOM | 3796 | O | GLU | B | 118 | −5.376 | 71.921 | −2.814 | 1.00 | 87.25 | | O |
| ANISOU | 3796 | O | GLU | B | 118 | 15555 | 9607 | 7988 | 1512 | 203 | 2241 | O |
| ATOM | 3797 | N | GLU | B | 118 | −6.436 | 70.146 | 0.085 | 1.00 | 61.09 | | N |
| ANISOU | 3797 | N | GLU | B | 118 | 11601 | 6434 | 5176 | 1460 | −219 | 1715 | N |
| ATOM | 3798 | CA | GLU | B | 118 | −6.546 | 70.434 | −1.339 | 1.00 | 76.15 | | C |
| ANISOU | 3798 | CA | GLU | B | 118 | 13745 | 8406 | 6781 | 1558 | −219 | 1855 | C |
| ATOM | 3799 | C | GLU | B | 118 | −5.903 | 71.774 | −1.715 | 1.00 | 82.02 | | C |
| ANISOU | 3799 | C | GLU | B | 118 | 14683 | 8917 | 7566 | 1522 | 42 | 2108 | C |
| ATOM | 3800 | CB | GLU | B | 118 | −8.012 | 70.438 | −1.782 | 1.00 | 83.34 | | C |
| ANISOU | 3800 | CB | GLU | B | 118 | 14619 | 9467 | 7580 | 1773 | −604 | 1837 | C |
| ATOM | 3801 | CG | GLU | B | 118 | −8.841 | 69.268 | −1.280 | 1.00 | 85.15 | | C |
| ANISOU | 3801 | CG | GLU | B | 118 | 14602 | 9906 | 7845 | 1789 | −896 | 1587 | C |
| ATOM | 3802 | CD | GLU | B | 118 | −10.142 | 69.123 | −2.049 | 1.00 | 92.57 | | C |
| ANISOU | 3802 | CD | GLU | B | 118 | 15510 | 11050 | 8613 | 1957 | −1245 | 1566 | C |
| ATOM | 3803 | OE1 | GLU | B | 118 | −10.284 | 69.791 | −3.095 | 1.00 | 98.17 | | O |
| ANISOU | 3803 | OE1 | GLU | B | 118 | 16427 | 11761 | 9111 | 2070 | −1250 | 1746 | O |
| ATOM | 3804 | OE2 | GLU | B | 118 | −11.017 | 68.344 | −1.615 | 1.00 | 90.81 | | O |
| ANISOU | 3804 | OE2 | GLU | B | 118 | 15044 | 10992 | 8468 | 1965 | −1510 | 1379 | O |
| ATOM | 3805 | O | ASN | B | 119 | −4.164 | 75.872 | −0.132 | 1.00 | 91.05 | | O |
| ANISOU | 3805 | O | ASN | B | 119 | 15981 | 9049 | 9567 | 1155 | 729 | 2548 | O |
| ATOM | 3806 | N | ASN | B | 119 | −5.970 | 72.753 | −0.815 | 1.00 | 78.35 | | N |
| ANISOU | 3806 | N | ASN | B | 119 | 14151 | 8215 | 7404 | 1498 | 81 | 2168 | N |
| ATOM | 3807 | CA | ASN | B | 119 | −5.468 | 74.101 | −1.104 | 1.00 | 83.34 | | C |
| ANISOU | 3807 | CA | ASN | B | 119 | 14964 | 8584 | 8119 | 1453 | 301 | 2398 | C |
| ATOM | 3808 | C | ASN | B | 119 | −4.621 | 74.734 | 0.003 | 1.00 | 88.52 | | C |
| ANISOU | 3808 | C | ASN | B | 119 | 15527 | 8977 | 9130 | 1234 | 542 | 2381 | C |
| ATOM | 3809 | CB | ASN | B | 119 | −6.632 | 75.029 | −1.445 | 1.00 | 78.98 | | C |
| ANISOU | 3809 | CB | ASN | B | 119 | 14500 | 7957 | 7550 | 1697 | 68 | 2535 | C |
| ATOM | 3810 | CG | ASN | B | 119 | −7.331 | 74.618 | −2.719 | 1.00 | 79.11 | | C |
| ANISOU | 3810 | CG | ASN | B | 119 | 14640 | 8218 | 7199 | 1885 | −138 | 2597 | C |
| ATOM | 3811 | OD1 | ASN | B | 119 | −6.848 | 74.889 | −3.821 | 1.00 | 77.51 | | O |
| ANISOU | 3811 | OD1 | ASN | B | 119 | 14674 | 8020 | 6756 | 1878 | 9 | 2775 | O |
| ATOM | 3812 | ND2 | ASN | B | 119 | −8.471 | 73.949 | −2.579 | 1.00 | 80.84 | | N |
| ANISOU | 3812 | ND2 | ASN | B | 119 | 14689 | 8654 | 7372 | 2039 | −480 | 2447 | N |
| ATOM | 3813 | O | GLU | B | 120 | −2.851 | 72.167 | 2.236 | 1.00 | 75.90 | | O |
| ANISOU | 3813 | O | GLU | B | 120 | 13385 | 7625 | 7827 | 783 | 792 | 1900 | O |
| ATOM | 3814 | N | GLU | B | 120 | −4.432 | 74.006 | 1.099 | 1.00 | 88.34 | | N |
| ANISOU | 3814 | N | GLU | B | 120 | 15276 | 9006 | 9284 | 1128 | 526 | 2176 | N |
| ATOM | 3815 | CA | GLU | B | 120 | −3.556 | 74.456 | 2.174 | 1.00 | 88.23 | | C |
| ANISOU | 3815 | CA | GLU | B | 120 | 15147 | 8782 | 9594 | 889 | 747 | 2124 | C |
| ATOM | 3816 | C | GLU | B | 120 | −2.671 | 73.308 | 2.655 | 1.00 | 84.88 | | C |
| ANISOU | 3816 | C | GLU | B | 120 | 14546 | 8515 | 9189 | 702 | 888 | 1976 | C |
| ATOM | 3817 | CB | GLU | B | 120 | −4.377 | 75.025 | 3.330 | 1.00 | 90.02 | | C |
| ANISOU | 3817 | CB | GLU | B | 120 | 15254 | 8852 | 10096 | 976 | 562 | 2021 | C |
| ATOM | 3818 | CG | GLU | B | 120 | −5.343 | 74.023 | 3.931 | 1.00 | 94.00 | | C |
| ANISOU | 3818 | CG | GLU | B | 120 | 15561 | 9574 | 10579 | 1133 | 265 | 1837 | C |
| ATOM | 3819 | CD | GLU | B | 120 | −6.139 | 74.595 | 5.084 | 1.00 | 98.80 | | C |
| ANISOU | 3819 | CD | GLU | B | 120 | 16030 | 10050 | 11458 | 1233 | 111 | 1725 | C |
| ATOM | 3820 | OE1 | GLU | B | 120 | −5.518 | 75.046 | 6.071 | 1.00 | 100.38 | | O |
| ANISOU | 3820 | OE1 | GLU | B | 120 | 16165 | 10053 | 11921 | 1056 | 265 | 1638 | O |
| ATOM | 3821 | OE2 | GLU | B | 120 | −7.386 | 74.586 | 5.006 | 1.00 | 100.24 | | O |
| ANISOU | 3821 | OE2 | GLU | B | 120 | 16150 | 10344 | 11594 | 1483 | −161 | 1705 | O |
| ATOM | 3822 | O | GLU | B | 121 | −2.068 | 72.008 | 5.840 | 1.00 | 90.60 | | O |
| ANISOU | 3822 | O | GLU | B | 121 | 14477 | 9415 | 10532 | 373 | 822 | 1420 | O |
| ATOM | 3823 | N | GLU | B | 121 | −1.759 | 73.608 | 3.576 | 1.00 | 88.30 | | N |
| ANISOU | 3823 | N | GLU | B | 121 | 14842 | 8805 | 9904 | 452 | 1099 | 1918 | N |
| ATOM | 3824 | CA | GLU | B | 121 | −0.719 | 72.667 | 3.974 | 1.00 | 84.54 | | C |
| ANISOU | 3824 | CA | GLU | B | 121 | 14160 | 8483 | 9477 | 247 | 1287 | 1804 | C |
| ATOM | 3825 | C | GLU | B | 121 | −1.194 | 71.689 | 5.032 | 1.00 | 86.93 | | C |
| ANISOU | 3825 | C | GLU | B | 121 | 14103 | 9011 | 9916 | 283 | 1043 | 1519 | C |
| ATOM | 3826 | CB | GLU | B | 121 | 0.499 | 73.427 | 4.516 | 1.00 | 83.26 | | C |
| ANISOU | 3826 | CB | GLU | B | 121 | 13891 | 8144 | 9600 | −72 | 1588 | 1818 | C |
| ATOM | 3827 | CG | GLU | B | 121 | 1.200 | 74.343 | 3.515 | 1.00 | 92.04 | | C |
| ANISOU | 3827 | CG | GLU | B | 121 | 15170 | 9140 | 10660 | −176 | 1829 | 2022 | C |
| ATOM | 3828 | CD | GLU | B | 121 | 1.714 | 73.602 | 2.298 | 1.00 | 100.76 | | C |
| ANISOU | 3828 | CD | GLU | B | 121 | 16348 | 10480 | 11458 | −131 | 1983 | 2112 | C |
| ATOM | 3829 | OE1 | GLU | B | 121 | 2.213 | 72.466 | 2.467 | 1.00 | 105.11 | | O |
| ANISOU | 3829 | OE1 | GLU | B | 121 | 16723 | 11256 | 11960 | −171 | 2058 | 1993 | O |
| ATOM | 3830 | OE2 | GLU | B | 121 | 1.618 | 74.154 | 1.177 | 1.00 | 99.85 | | O |
| ANISOU | 3830 | OE2 | GLU | B | 121 | 16468 | 10321 | 11148 | −46 | 2032 | 2296 | O |
| ATOM | 3831 | O | CYS | B | 122 | 1.267 | 69.531 | 7.119 | 1.00 | 69.46 | | O |
| ANISOU | 3831 | O | CYS | B | 122 | 10944 | 7306 | 8142 | −175 | 1297 | 1054 | O |
| ATOM | 3832 | N | CYS | B | 122 | −0.630 | 70.483 | 5.000 | 1.00 | 84.11 | | N |
| ANISOU | 3832 | N | CYS | B | 122 | 13554 | 8908 | 9496 | 228 | 1099 | 1398 | N |
| ATOM | 3833 | CA | CYS | B | 122 | −0.868 | 69.505 | 6.052 | 1.00 | 72.29 | | C |
| ANISOU | 3833 | CA | CYS | B | 122 | 11713 | 7608 | 8147 | 224 | 923 | 1155 | C |
| ATOM | 3834 | C | CYS | B | 122 | 0.066 | 69.771 | 7.211 | 1.00 | 63.99 | | C |
| ANISOU | 3834 | C | CYS | B | 122 | 10369 | 6540 | 7404 | −11 | 1057 | 1046 | C |
| ATOM | 3835 | CB | CYS | B | 122 | −0.657 | 68.073 | 5.555 | 1.00 | 64.47 | | C |
| ANISOU | 3835 | CB | CYS | B | 122 | 10660 | 6860 | 6975 | 281 | 925 | 1071 | C |
| ATOM | 3836 | SG | CYS | B | 122 | −2.143 | 67.209 | 5.047 | 1.00 | 43.13 | | S |
| ANISOU | 3836 | SG | CYS | B | 122 | 8066 | 4285 | 4036 | 528 | 573 | 1001 | S |
| ATOM | 3837 | O | PRO | B | 123 | 0.415 | 67.971 | 9.540 | 1.00 | 46.93 | | O |
| ANISOU | 3837 | O | PRO | B | 123 | 7492 | 4784 | 5557 | −108 | 866 | 647 | O |
| ATOM | 3838 | N | PRO | B | 123 | −0.490 | 70.231 | 8.325 | 1.00 | 51.70 | | N |
| ANISOU | 3838 | N | PRO | B | 123 | 8676 | 4918 | 6050 | −18 | 894 | 928 | N |
| ATOM | 3839 | CA | PRO | B | 123 | 0.274 | 70.353 | 9.565 | 1.00 | 47.17 | | C |
| ANISOU | 3839 | CA | PRO | B | 123 | 7802 | 4382 | 5738 | −226 | 954 | 776 | C |
| ATOM | 3840 | C | PRO | B | 123 | 0.885 | 69.020 | 9.986 | 1.00 | 44.95 | | C |
| ANISOU | 3840 | C | PRO | B | 123 | 7221 | 4391 | 5468 | −264 | 963 | 657 | C |
| ATOM | 3841 | CB | PRO | B | 123 | −0.781 | 70.787 | 10.575 | 1.00 | 45.62 | | C |
| ANISOU | 3841 | CB | PRO | B | 123 | 7548 | 4123 | 5661 | −132 | 723 | 651 | C |
| ATOM | 3842 | CG | PRO | B | 123 | −2.059 | 70.256 | 10.020 | 1.00 | 45.23 | | C |
| ANISOU | 3842 | CG | PRO | B | 123 | 7616 | 4145 | 5425 | 131 | 510 | 690 | C |
| ATOM | 3843 | CD | PRO | B | 123 | −1.931 | 70.421 | 8.542 | 1.00 | 48.26 | | C |
| ANISOU | 3843 | CD | PRO | B | 123 | 8311 | 4442 | 5586 | 196 | 616 | 898 | C |
| ATOM | 3844 | O | PHE | B | 124 | 3.391 | 65.838 | 10.589 | 1.00 | 50.96 | | O |
| ANISOU | 3844 | O | PHE | B | 124 | 7269 | 5795 | 6298 | −344 | 1204 | 483 | O |
| ATOM | 3845 | N | PHE | B | 124 | 1.915 | 69.076 | 10.824 | 1.00 | 39.84 | | N |
| ANISOU | 3845 | N | PHE | B | 124 | 6307 | 3820 | 5011 | −465 | 1068 | 566 | N |
| ATOM | 3846 | CA | PHE | B | 124 | 2.541 | 67.898 | 11.408 | 1.00 | 36.19 | | C |
| ANISOU | 3846 | CA | PHE | B | 124 | 5532 | 3625 | 4592 | −483 | 1063 | 462 | C |
| ATOM | 3847 | C | PHE | B | 124 | 3.217 | 67.035 | 10.375 | 1.00 | 43.55 | | C |
| ANISOU | 3847 | C | PHE | B | 124 | 6497 | 4668 | 5383 | −432 | 1242 | 550 | C |
| ATOM | 3848 | CB | PHE | B | 124 | 1.495 | 67.069 | 12.160 | 1.00 | 33.08 | | C |
| ANISOU | 3848 | CB | PHE | B | 124 | 5040 | 3356 | 4175 | −320 | 801 | 349 | C |
| ATOM | 3849 | CG | PHE | B | 124 | 0.558 | 67.908 | 12.971 | 1.00 | 34.35 | | C |
| ANISOU | 3849 | CG | PHE | B | 124 | 5230 | 3405 | 4417 | −300 | 632 | 273 | C |
| ATOM | 3850 | CD2 | PHE | B | 124 | −0.802 | 67.875 | 12.730 | 1.00 | 36.25 | | C |
| ANISOU | 3850 | CD2 | PHE | B | 124 | 5622 | 3592 | 4559 | −110 | 453 | 287 | C |
| ATOM | 3851 | CD1 | PHE | B | 124 | 1.042 | 68.757 | 13.953 | 1.00 | 31.78 | | C |
| ANISOU | 3851 | CD1 | PHE | B | 124 | 4776 | 3033 | 4266 | −471 | 654 | 173 | C |
| ATOM | 3852 | CE2 | PHE | B | 124 | −1.673 | 68.669 | 13.473 | 1.00 | 38.26 | | C |
| ANISOU | 3852 | CE2 | PHE | B | 124 | 5889 | 3751 | 4896 | −59 | 322 | 214 | C |
| ATOM | 3853 | CE1 | PHE | B | 124 | 0.183 | 69.545 | 14.697 | 1.00 | 31.61 | | C |
| ANISOU | 3853 | CE1 | PHE | B | 124 | 4804 | 2896 | 4310 | −431 | 521 | 79 | C |
| ATOM | 3854 | CZ | PHE | B | 124 | −1.179 | 69.504 | 14.453 | 1.00 | 32.10 | | C |
| ANISOU | 3854 | CZ | PHE | B | 124 | 5011 | 2907 | 4280 | −210 | 367 | 106 | C |
| ATOM | 3855 | O | LYS | B | 125 | 4.205 | 64.720 | 7.335 | 1.00 | 49.73 | | O |
| ANISOU | 3855 | O | LYS | B | 125 | 7600 | 5672 | 5623 | −129 | 1662 | 705 | O |
| ATOM | 3856 | N | LYS | B | 125 | 3.566 | 67.643 | 9.248 | 1.00 | 50.84 | | N |
| ANISOU | 3856 | N | LYS | B | 125 | 7657 | 5461 | 6200 | −472 | 1447 | 704 | N |
| ATOM | 3857 | CA | LYS | B | 125 | 4.273 | 66.960 | 8.168 | 1.00 | 52.88 | | C |
| ANISOU | 3857 | CA | LYS | B | 125 | 7979 | 5819 | 6293 | −424 | 1670 | 789 | C |
| ATOM | 3858 | C | LYS | B | 125 | 3.560 | 65.699 | 7.691 | 1.00 | 46.29 | | C |
| ANISOU | 3858 | C | LYS | B | 125 | 7245 | 5093 | 5250 | −188 | 1530 | 734 | C |
| ATOM | 3859 | CB | LYS | B | 125 | 5.707 | 66.625 | 8.586 | 1.00 | 57.33 | | C |
| ANISOU | 3859 | CB | LYS | B | 125 | 8196 | 6560 | 7029 | −575 | 1881 | 751 | C |
| ATOM | 3860 | CG | LYS | B | 125 | 6.638 | 67.831 | 8.595 | 1.00 | 65.89 | | C |
| ANISOU | 3860 | CG | LYS | B | 125 | 9218 | 7541 | 8278 | −850 | 2107 | 835 | C |
| ATOM | 3861 | CD | LYS | B | 125 | 8.040 | 67.449 | 9.043 | 1.00 | 72.03 | | C |
| ANISOU | 3861 | CD | LYS | B | 125 | 9585 | 8546 | 9239 | −997 | 2286 | 784 | C |
| ATOM | 3862 | CE | LYS | B | 125 | 9.066 | 68.486 | 8.599 | 1.00 | 83.10 | | C |
| ANISOU | 3862 | CE | LYS | B | 125 | 10955 | 9864 | 10757 | −1278 | 2596 | 907 | C |
| ATOM | 3863 | NZ | LYS | B | 125 | 8.438 | 69.764 | 8.155 | 1.00 | 87.52 | | N |
| ANISOU | 3863 | NZ | LYS | B | 125 | 11886 | 10088 | 11279 | −1373 | 2613 | 1030 | N |
| ATOM | 3864 | O | LEU | B | 126 | 1.415 | 65.563 | 5.026 | 1.00 | 41.88 | | O |
| ANISOU | 3864 | O | LEU | B | 126 | 7526 | 4389 | 3997 | 205 | 1312 | 902 | O |
| ATOM | 3865 | N | LEU | B | 126 | 2.230 | 65.730 | 7.665 | 1.00 | 42.96 | | N |
| ANISOU | 3865 | N | LEU | B | 126 | 6996 | 4595 | 4731 | −55 | 1269 | 712 | N |
| ATOM | 3866 | CA | LEU | B | 126 | 1.449 | 64.581 | 7.213 | 1.00 | 36.83 | | C |
| ANISOU | 3866 | CA | LEU | B | 126 | 6318 | 3904 | 3772 | 129 | 1105 | 642 | C |
| ATOM | 3867 | C | LEU | B | 126 | 1.342 | 64.538 | 5.698 | 1.00 | 38.52 | | C |
| ANISOU | 3867 | C | LEU | B | 126 | 6879 | 4085 | 3671 | 234 | 1200 | 743 | C |
| ATOM | 3868 | CB | LEU | B | 126 | 0.044 | 64.611 | 7.811 | 1.00 | 32.03 | | C |
| ANISOU | 3868 | CB | LEU | B | 126 | 5706 | 3266 | 3198 | 214 | 780 | 571 | C |
| ATOM | 3869 | CG | LEU | B | 126 | −0.045 | 64.590 | 9.331 | 1.00 | 29.90 | | C |
| ANISOU | 3869 | CG | LEU | B | 126 | 5125 | 3050 | 3184 | 140 | 666 | 463 | C |
| ATOM | 3870 | CD1 | LEU | B | 126 | −1.447 | 64.911 | 9.774 | 1.00 | 28.88 | | C |
| ANISOU | 3870 | CD1 | LEU | B | 126 | 5023 | 2878 | 3073 | 227 | 401 | 425 | C |
| ATOM | 3871 | CD2 | LEU | B | 126 | 0.365 | 63.230 | 9.818 | 1.00 | 28.56 | | C |
| ANISOU | 3871 | CD2 | LEU | B | 126 | 4741 | 3040 | 3069 | 158 | 666 | 364 | C |
| ATOM | 3872 | O | ASN | B | 127 | −1.365 | 63.836 | 4.191 | 1.00 | 36.79 | | O |
| ANISOU | 3872 | O | ASN | B | 127 | 7161 | 3874 | 2942 | 581 | 645 | 693 | O |
| ATOM | 3873 | N | ASN | B | 127 | 1.144 | 63.345 | 5.156 | 1.00 | 38.86 | | N |
| ANISOU | 3873 | N | ASN | B | 127 | 6994 | 4227 | 3544 | 358 | 1153 | 651 | N |
| ATOM | 3874 | CA | ASN | B | 127 | 0.917 | 63.208 | 3.732 | 1.00 | 43.75 | | C |
| ANISOU | 3874 | CA | ASN | B | 127 | 7965 | 4844 | 3814 | 475 | 1198 | 708 | C |
| ATOM | 3875 | C | ASN | B | 127 | −0.451 | 63.777 | 3.359 | 1.00 | 46.55 | | C |
| ANISOU | 3875 | C | ASN | B | 127 | 8543 | 5126 | 4018 | 571 | 908 | 760 | C |
| ATOM | 3876 | CB | ASN | B | 127 | 0.998 | 61.741 | 3.306 | 1.00 | 49.82 | | C |
| ANISOU | 3876 | CB | ASN | B | 127 | 8765 | 5717 | 4447 | 580 | 1196 | 547 | C |
| ATOM | 3877 | CG | ASN | B | 127 | 2.357 | 61.124 | 3.572 | 1.00 | 49.45 | | C |
| ANISOU | 3877 | CG | ASN | B | 127 | 8503 | 5751 | 4536 | 544 | 1491 | 506 | C |
| ATOM | 3878 | OD1 | ASN | B | 127 | 3.393 | 61.777 | 3.466 | 1.00 | 51.03 | | O |
| ANISOU | 3878 | OD1 | ASN | B | 127 | 8632 | 5965 | 4792 | 453 | 1776 | 625 | O |
| ATOM | 3879 | ND2 | ASN | B | 127 | 2.353 | 59.855 | 3.932 | 1.00 | 44.05 | | N |
| ANISOU | 3879 | ND2 | ASN | B | 127 | 7701 | 5115 | 3921 | 617 | 1424 | 345 | N |
| ATOM | 3880 | O | CYS | B | 128 | −1.807 | 63.708 | −0.608 | 1.00 | 47.00 | | O |
| ANISOU | 3880 | O | CYS | B | 128 | 9682 | 5287 | 2888 | 972 | 737 | 935 | O |
| ATOM | 3881 | N | CYS | B | 128 | −0.583 | 64.192 | 2.105 | 1.00 | 41.57 | | N |
| ANISOU | 3881 | N | CYS | B | 128 | 8258 | 4472 | 3067 | 656 | 963 | 890 | N |
| ATOM | 3882 | CA | CYS | B | 128 | −1.861 | 64.644 | 1.584 | 1.00 | 42.56 | | C |
| ANISOU | 3882 | CA | CYS | B | 128 | 8608 | 4565 | 2999 | 791 | 672 | 952 | C |
| ATOM | 3883 | C | CYS | B | 128 | −2.340 | 63.704 | 0.497 | 1.00 | 44.21 | | C |
| ANISOU | 3883 | C | CYS | B | 128 | 9051 | 4899 | 2845 | 923 | 542 | 855 | C |
| ATOM | 3884 | CB | CYS | B | 128 | −1.769 | 66.058 | 1.023 | 1.00 | 45.12 | | C |
| ANISOU | 3884 | CB | CYS | B | 128 | 9181 | 4742 | 3220 | 805 | 790 | 1216 | C |
| ATOM | 3885 | SG | CYS | B | 128 | −3.351 | 66.624 | 0.392 | 1.00 | 49.48 | | S |
| ANISOU | 3885 | SG | CYS | B | 128 | 9992 | 5274 | 3536 | 1027 | 407 | 1317 | S |
| ATOM | 3886 | O | VAL | B | 129 | −6.196 | 62.215 | 0.464 | 1.00 | 46.38 | | O |
| ANISOU | 3886 | O | VAL | B | 129 | 9239 | 5418 | 2965 | 1141 | −597 | 473 | O |
| ATOM | 3887 | N | VAL | B | 129 | −3.355 | 62.907 | 0.819 | 1.00 | 48.18 | | N |
| ANISOU | 3887 | N | VAL | B | 129 | 9446 | 5475 | 3386 | 967 | 216 | 673 | N |
| ATOM | 3888 | CA | VAL | B | 129 | −3.880 | 61.906 | −0.099 | 1.00 | 44.45 | | C |
| ANISOU | 3888 | CA | VAL | B | 129 | 9168 | 5115 | 2606 | 1055 | 47 | 521 | C |
| ATOM | 3889 | C | VAL | B | 129 | −5.352 | 62.156 | −0.431 | 1.00 | 45.50 | | C |
| ANISOU | 3889 | C | VAL | B | 129 | 9384 | 5308 | 2597 | 1162 | −363 | 522 | C |
| ATOM | 3890 | CB | VAL | B | 129 | −3.712 | 60.495 | 0.502 | 1.00 | 42.54 | | C |
| ANISOU | 3890 | CB | VAL | B | 129 | 8716 | 4905 | 2543 | 985 | 33 | 272 | C |
| ATOM | 3891 | CG1 | VAL | B | 129 | −4.299 | 59.418 | −0.421 | 1.00 | 44.59 | | C |
| ANISOU | 3891 | CG1 | VAL | B | 129 | 9191 | 5244 | 2508 | 1048 | −158 | 71 | C |
| ATOM | 3892 | CG2 | VAL | B | 129 | −2.244 | 60.223 | 0.778 | 1.00 | 42.01 | | C |
| ANISOU | 3892 | CG2 | VAL | B | 129 | 8548 | 4809 | 2605 | 923 | 425 | 279 | C |
| ATOM | 3893 | O | LYS | B | 130 | −8.736 | 63.815 | −1.183 | 1.00 | 59.02 | | O |
| ANISOU | 3893 | O | LYS | B | 130 | 10987 | 7172 | 4264 | 1443 | −1206 | 681 | O |
| ATOM | 3894 | N | LYS | B | 130 | −5.641 | 62.274 | −1.726 | 1.00 | 48.92 | | N |
| ANISOU | 3894 | N | LYS | B | 130 | 10027 | 5814 | 2747 | 1246 | −427 | 549 | N |
| ATOM | 3895 | CA | LYS | B | 130 | −6.972 | 62.602 | −2.226 | 1.00 | 50.83 | | C |
| ANISOU | 3895 | CA | LYS | B | 130 | 10261 | 6145 | 2908 | 1340 | −786 | 558 | C |
| ATOM | 3896 | C | LYS | B | 130 | −7.555 | 63.799 | −1.498 | 1.00 | 49.83 | | C |
| ANISOU | 3896 | C | LYS | B | 130 | 10001 | 5936 | 2997 | 1394 | −891 | 736 | C |
| ATOM | 3897 | CB | LYS | B | 130 | −7.922 | 61.413 | −2.077 | 1.00 | 57.74 | | C |
| ANISOU | 3897 | CB | LYS | B | 130 | 10990 | 7135 | 3813 | 1298 | −1106 | 295 | C |
| ATOM | 3898 | CG | LYS | B | 130 | −7.606 | 60.197 | −2.933 | 1.00 | 63.60 | | C |
| ANISOU | 3898 | CG | LYS | B | 130 | 11883 | 7945 | 4337 | 1258 | −1068 | 82 | C |
| ATOM | 3899 | CD | LYS | B | 130 | −8.601 | 59.071 | −2.625 | 1.00 | 66.23 | | C |
| ANISOU | 3899 | CD | LYS | B | 130 | 12042 | 8347 | 4777 | 1171 | −1388 | −176 | C |
| ATOM | 3900 | CE | LYS | B | 130 | −8.362 | 57.828 | −3.465 | 1.00 | 68.79 | | C |
| ANISOU | 3900 | CE | LYS | B | 130 | 12527 | 8702 | 4909 | 1121 | −1365 | −416 | C |
| ATOM | 3901 | NZ | LYS | B | 130 | −9.338 | 56.750 | −3.121 | 1.00 | 69.46 | | N |
| ANISOU | 3901 | NZ | LYS | B | 130 | 12433 | 8818 | 5140 | 995 | −1663 | −664 | N |
| ATOM | 3902 | N | GLY | B | 131 | −6.734 | 64.807 | −1.238 | 1.00 | 49.55 | | N |
| ANISOU | 3902 | N | GLY | B | 131 | 10033 | 5744 | 3049 | 1378 | −613 | 939 | N |
| ATOM | 3903 | CA | GLY | B | 131 | −7.237 | 66.033 | −0.654 | 1.00 | 49.30 | | C |
| ANISOU | 3903 | CA | GLY | B | 131 | 9921 | 5592 | 3220 | 1440 | −683 | 1103 | C |
| ATOM | 3904 | C | GLY | B | 131 | −7.405 | 66.027 | 0.855 | 1.00 | 45.71 | | C |
| ANISOU | 3904 | C | GLY | B | 131 | 9210 | 5063 | 3093 | 1386 | −738 | 1040 | C |
| ATOM | 3905 | O | GLY | B | 131 | −7.778 | 67.052 | 1.421 | 1.00 | 45.59 | | O |
| ANISOU | 3905 | O | GLY | B | 131 | 9126 | 4926 | 3270 | 1443 | −773 | 1151 | O |
| ATOM | 3906 | N | LYS | B | 132 | −7.151 | 64.888 | 1.502 | 1.00 | 43.13 | | N |
| ANISOU | 3906 | N | LYS | B | 132 | 8694 | 4811 | 2881 | 1266 | −730 | 839 | N |
| ATOM | 3907 | CA | LYS | B | 132 | −7.236 | 64.785 | 2.961 | 1.00 | 39.91 | | C |
| ANISOU | 3907 | CA | LYS | B | 132 | 7918 | 4374 | 2871 | 1160 | −734 | 731 | C |
| ATOM | 3908 | C | LYS | B | 132 | −5.878 | 64.461 | 3.581 | 1.00 | 39.34 | | C |
| ANISOU | 3908 | C | LYS | B | 132 | 7724 | 4246 | 2978 | 985 | −406 | 686 | C |
| ATOM | 3909 | O | LYS | B | 132 | −5.032 | 63.843 | 2.951 | 1.00 | 38.72 | | O |
| ANISOU | 3909 | O | LYS | B | 132 | 7770 | 4199 | 2744 | 943 | −220 | 659 | O |
| ATOM | 3910 | CB | LYS | B | 132 | −8.246 | 63.720 | 3.404 | 1.00 | 38.69 | | C |
| ANISOU | 3910 | CB | LYS | B | 132 | 7525 | 4372 | 2802 | 1145 | −1022 | 528 | C |
| ATOM | 3911 | CG | LYS | B | 132 | −9.688 | 63.937 | 2.970 | 1.00 | 44.16 | | C |
| ANISOU | 3911 | CG | LYS | B | 132 | 8225 | 5173 | 3379 | 1301 | −1388 | 539 | C |
| ATOM | 3912 | CD | LYS | B | 132 | −10.560 | 62.769 | 3.455 | 1.00 | 42.61 | | C |
| ANISOU | 3912 | CD | LYS | B | 132 | 7756 | 5127 | 3307 | 1218 | −1627 | 324 | C |
| ATOM | 3913 | CE | LYS | B | 132 | −11.995 | 62.853 | 2.953 | 1.00 | 45.10 | | C |
| ANISOU | 3913 | CE | LYS | B | 132 | 7997 | 5599 | 3539 | 1332 | −1985 | 304 | C |
| ATOM | 3914 | NZ | LYS | B | 132 | −12.138 | 62.641 | 1.485 | 1.00 | 54.29 | | N |
| ANISOU | 3914 | NZ | LYS | B | 132 | 9385 | 6846 | 4396 | 1367 | −2056 | 294 | N |
| ATOM | 3915 | N | CYS | B | 133 | −5.664 | 64.882 | 4.818 | 1.00 | 35.91 | | N |
| ANISOU | 3915 | N | CYS | B | 133 | 7039 | 3746 | 2861 | 897 | −337 | 669 | N |
| ATOM | 3916 | CA | CYS | B | 133 | −4.438 | 64.532 | 5.506 | 1.00 | 37.75 | | C |
| ANISOU | 3916 | CA | CYS | B | 133 | 7101 | 3968 | 3272 | 737 | −78 | 615 | C |
| ATOM | 3917 | C | CYS | B | 133 | −4.474 | 63.060 | 5.944 | 1.00 | 39.67 | | C |
| ANISOU | 3917 | C | CYS | B | 133 | 7153 | 4341 | 3581 | 694 | −146 | 431 | C |
| ATOM | 3918 | O | CYS | B | 133 | −5.386 | 62.612 | 6.652 | 1.00 | 36.88 | | O |
| ANISOU | 3918 | O | CYS | B | 133 | 6611 | 4049 | 3351 | 701 | −361 | 333 | O |
| ATOM | 3919 | CB | CYS | B | 133 | −4.214 | 65.469 | 6.692 | 1.00 | 36.22 | | C |
| ANISOU | 3919 | CB | CYS | B | 133 | 6718 | 3678 | 3367 | 653 | −11 | 637 | C |
| ATOM | 3920 | SG | CYS | B | 133 | −3.863 | 67.173 | 6.150 | 1.00 | 49.53 | | S |
| ANISOU | 3920 | SG | CYS | B | 133 | 8672 | 5132 | 5016 | 660 | 151 | 859 | S |
| ATOM | 3921 | N | GLU | B | 134 | −3.481 | 62.302 | 5.503 | 1.00 | 37.84 | | N |
| ANISOU | 3921 | N | GLU | B | 134 | 6973 | 4138 | 3268 | 655 | 56 | 394 | N |
| ATOM | 3922 | CA | GLU | B | 134 | −3.524 | 60.853 | 5.672 | 1.00 | 36.69 | | C |
| ANISOU | 3922 | CA | GLU | B | 134 | 6730 | 4065 | 3145 | 646 | 1 | 231 | C |
| ATOM | 3923 | C | GLU | B | 134 | −3.195 | 60.422 | 7.085 | 1.00 | 34.46 | | C |
| ANISOU | 3923 | C | GLU | B | 134 | 6118 | 3810 | 3165 | 560 | 31 | 172 | C |
| ATOM | 3924 | O | GLU | B | 134 | −2.212 | 60.882 | 7.668 | 1.00 | 33.76 | | O |
| ANISOU | 3924 | O | GLU | B | 134 | 5893 | 3716 | 3219 | 491 | 226 | 227 | O |
| ATOM | 3925 | CB | GLU | B | 134 | −2.559 | 60.161 | 4.712 | 1.00 | 42.32 | | C |
| ANISOU | 3925 | CB | GLU | B | 134 | 7624 | 4790 | 3666 | 675 | 224 | 201 | C |
| ATOM | 3926 | CG | GLU | B | 134 | −2.674 | 58.642 | 4.754 | 1.00 | 54.48 | | C |
| ANISOU | 3926 | CG | GLU | B | 134 | 9130 | 6352 | 5218 | 690 | 160 | 19 | C |
| ATOM | 3927 | CD | GLU | B | 134 | −1.545 | 57.940 | 4.024 | 1.00 | 67.39 | | C |
| ANISOU | 3927 | CD | GLU | B | 134 | 10898 | 7988 | 6720 | 741 | 435 | −28 | C |
| ATOM | 3928 | OE1 | GLU | B | 134 | −0.423 | 58.490 | 3.987 | 1.00 | 67.58 | | O |
| ANISOU | 3928 | OE1 | GLU | B | 134 | 10878 | 8027 | 6772 | 726 | 719 | 81 | O |
| ATOM | 3929 | OE2 | GLU | B | 134 | −1.778 | 56.833 | 3.490 | 1.00 | 78.09 | | O |
| ANISOU | 3929 | OE2 | GLU | B | 134 | 12394 | 9324 | 7952 | 792 | 377 | −186 | O |
| ATOM | 3930 | N | TYR | B | 135 | −4.032 | 59.551 | 7.639 | 1.00 | 33.15 | | N |
| ANISOU | 3930 | N | TYR | B | 135 | 5822 | 3683 | 3091 | 553 | −167 | 65 | N |
| ATOM | 3931 | CA | TYR | B | 135 | −3.665 | 58.813 | 8.835 | 1.00 | 28.59 | | C |
| ANISOU | 3931 | CA | TYR | B | 135 | 4981 | 3138 | 2742 | 492 | −124 | 17 | C |
| ATOM | 3932 | C | TYR | B | 135 | −2.969 | 57.539 | 8.382 | 1.00 | 31.92 | | C |
| ANISOU | 3932 | C | TYR | B | 135 | 5477 | 3537 | 3113 | 520 | −1 | −60 | C |
| ATOM | 3933 | O | TYR | B | 135 | −3.435 | 56.884 | 7.456 | 1.00 | 32.27 | | O |
| ANISOU | 3933 | O | TYR | B | 135 | 5725 | 3545 | 2990 | 559 | −85 | −147 | O |
| ATOM | 3934 | CB | TYR | B | 135 | −4.888 | 58.462 | 9.704 | 1.00 | 27.32 | | C |
| ANISOU | 3934 | CB | TYR | B | 135 | 4646 | 3020 | 2715 | 461 | −358 | −36 | C |
| ATOM | 3935 | CG | TYR | B | 135 | −4.517 | 57.553 | 10.879 | 1.00 | 31.93 | | C |
| ANISOU | 3935 | CG | TYR | B | 135 | 5001 | 3636 | 3496 | 409 | −306 | −60 | C |
| ATOM | 3936 | CD1 | TYR | B | 135 | −3.825 | 58.061 | 11.973 | 1.00 | 28.13 | | C |
| ANISOU | 3936 | CD1 | TYR | B | 135 | 4317 | 3213 | 3159 | 375 | −199 | −4 | C |
| ATOM | 3937 | CD2 | TYR | B | 135 | −4.812 | 56.191 | 10.872 | 1.00 | 35.98 | | C |
| ANISOU | 3937 | CD2 | TYR | B | 135 | 5521 | 4112 | 4040 | 394 | −363 | −136 | C |
| ATOM | 3938 | CE1 | TYR | B | 135 | −3.463 | 57.266 | 13.037 | 1.00 | 28.83 | | C |
| ANISOU | 3938 | CE1 | TYR | B | 135 | 4210 | 3354 | 3390 | 352 | −164 | −1 | C |
| ATOM | 3939 | CE2 | TYR | B | 135 | −4.448 | 55.368 | 11.955 | 1.00 | 30.73 | | C |
| ANISOU | 3939 | CE2 | TYR | B | 135 | 4671 | 3458 | 3547 | 368 | −304 | −118 | C |
| ATOM | 3940 | CZ | TYR | B | 135 | −3.771 | 55.927 | 13.034 | 1.00 | 34.64 | | C |
| ANISOU | 3940 | CZ | TYR | B | 135 | 4963 | 4045 | 4155 | 360 | −210 | −39 | C |
| ATOM | 3941 | OH | TYR | B | 135 | −3.378 | 55.171 | 14.122 | 1.00 | 37.01 | | O |
| ANISOU | 3941 | OH | TYR | B | 135 | 5086 | 4384 | 4590 | 357 | −165 | 3 | O |
| ATOM | 3942 | N | MET | B | 136 | −1.855 | 57.193 | 9.010 | 1.00 | 35.65 | | N |
| ANISOU | 3942 | N | MET | B | 136 | 5789 | 4033 | 3725 | 512 | 190 | −39 | N |
| ATOM | 3943 | CA | MET | B | 136 | −1.260 | 55.879 | 8.772 | 1.00 | 37.53 | | C |
| ANISOU | 3943 | CA | MET | B | 136 | 6066 | 4232 | 3963 | 576 | 300 | −114 | C |
| ATOM | 3944 | C | MET | B | 136 | −0.429 | 55.410 | 9.954 | 1.00 | 41.17 | | C |
| ANISOU | 3944 | C | MET | B | 136 | 6252 | 4742 | 4648 | 579 | 401 | −73 | C |
| ATOM | 3945 | O | MET | B | 136 | 0.273 | 56.196 | 10.597 | 1.00 | 39.78 | | O |
| ANISOU | 3945 | O | MET | B | 136 | 5885 | 4658 | 4570 | 538 | 493 | 8 | O |
| ATOM | 3946 | CB | MET | B | 136 | −0.404 | 55.875 | 7.505 | 1.00 | 36.24 | | C |
| ANISOU | 3946 | CB | MET | B | 136 | 6124 | 4050 | 3596 | 654 | 518 | −125 | C |
| ATOM | 3947 | CG | MET | B | 136 | 0.769 | 56.839 | 7.516 | 1.00 | 48.96 | | C |
| ANISOU | 3947 | CG | MET | B | 136 | 7635 | 5733 | 5234 | 633 | 764 | −6 | C |
| ATOM | 3948 | SD | MET | B | 136 | 1.579 | 56.878 | 5.903 | 1.00 | 80.38 | | S |
| ANISOU | 3948 | SD | MET | B | 136 | 11905 | 9709 | 8926 | 721 | 1039 | −3 | S |
| ATOM | 3949 | CE | MET | B | 136 | 1.476 | 55.139 | 5.451 | 1.00 | 43.61 | | C |
| ANISOU | 3949 | CE | MET | B | 136 | 7398 | 4974 | 4196 | 857 | 1028 | −191 | C |
| ATOM | 3950 | N | GLN | B | 137 | −0.506 | 54.109 | 10.212 | 1.00 | 39.10 | | N |
| ANISOU | 3950 | N | GLN | B | 137 | 5984 | 4411 | 4461 | 629 | 377 | −131 | N |
| ATOM | 3951 | CA | GLN | B | 137 | 0.175 | 53.501 | 11.340 | 1.00 | 35.91 | | C |
| ANISOU | 3951 | CA | GLN | B | 137 | 5342 | 4049 | 4252 | 667 | 443 | −71 | C |
| ATOM | 3952 | C | GLN | B | 137 | 0.615 | 52.066 | 11.054 | 1.00 | 36.95 | | C |
| ANISOU | 3952 | C | GLN | B | 137 | 5571 | 4053 | 4414 | 794 | 541 | −128 | C |
| ATOM | 3953 | O | GLN | B | 137 | −0.183 | 51.219 | 10.643 | 1.00 | 36.35 | | O |
| ANISOU | 3953 | O | GLN | B | 137 | 5684 | 3823 | 4304 | 784 | 437 | −226 | O |
| ATOM | 3954 | CB | GLN | B | 137 | −0.726 | 53.534 | 12.568 | 1.00 | 34.90 | | C |
| ANISOU | 3954 | CB | GLN | B | 137 | 5043 | 3964 | 4253 | 578 | 251 | −28 | C |
| ATOM | 3955 | CG | GLN | B | 137 | −0.056 | 53.014 | 13.830 | 1.00 | 41.77 | | C |
| ANISOU | 3955 | CG | GLN | B | 137 | 5673 | 4911 | 5288 | 623 | 298 | 63 | C |
| ATOM | 3956 | CD | GLN | B | 137 | 1.060 | 53.934 | 14.327 | 1.00 | 40.98 | | C |
| ANISOU | 3956 | CD | GLN | B | 137 | 5358 | 4987 | 5226 | 621 | 408 | 129 | C |
| ATOM | 3957 | OE1 | GLN | B | 137 | 0.805 | 55.042 | 14.800 | 1.00 | 44.19 | | O |
| ANISOU | 3957 | OE1 | GLN | B | 137 | 5669 | 5490 | 5633 | 518 | 339 | 141 | O |
| ATOM | 3958 | NE2 | GLN | B | 137 | 2.300 | 53.460 | 14.240 | 1.00 | 39.93 | | N |
| ANISOU | 3958 | NE2 | GLN | B | 137 | 5138 | 4895 | 5140 | 736 | 577 | 161 | N |
| ATOM | 3959 | N | SER | B | 138 | 1.904 | 51.811 | 11.248 | 1.00 | 39.60 | | N |
| ANISOU | 3959 | N | SER | B | 138 | 5774 | 4449 | 4825 | 915 | 742 | −75 | N |
| ATOM | 3960 | CA | SER | B | 138 | 2.433 | 50.450 | 11.290 | 1.00 | 42.35 | | C |
| ANISOU | 3960 | CA | SER | B | 138 | 6156 | 4676 | 5259 | 1079 | 845 | −96 | C |
| ATOM | 3961 | C | SER | B | 138 | 2.625 | 50.075 | 12.743 | 1.00 | 41.36 | | C |
| ANISOU | 3961 | C | SER | B | 138 | 5767 | 4617 | 5331 | 1104 | 781 | 35 | C |
| ATOM | 3962 | O | SER | B | 138 | 3.176 | 50.856 | 13.519 | 1.00 | 43.49 | | O |
| ANISOU | 3962 | O | SER | B | 138 | 5773 | 5094 | 5659 | 1071 | 786 | 133 | O |
| ATOM | 3963 | CB | SER | B | 138 | 3.759 | 50.330 | 10.541 | 1.00 | 42.83 | | C |
| ANISOU | 3963 | CB | SER | B | 138 | 6222 | 4778 | 5273 | 1247 | 1123 | −114 | C |
| ATOM | 3964 | OG | SER | B | 138 | 3.570 | 50.463 | 9.148 | 1.00 | 49.54 | | O |
| ANISOU | 3964 | OG | SER | B | 138 | 7369 | 5553 | 5900 | 1251 | 1201 | −239 | O |
| ATOM | 3965 | N | TYR | B | 139 | 2.115 | 48.918 | 13.132 | 1.00 | 35.30 | | N |
| ANISOU | 3965 | N | TYR | B | 139 | 5083 | 3674 | 4657 | 1143 | 708 | 39 | N |
| ATOM | 3966 | CA | TYR | B | 139 | 2.335 | 48.448 | 14.485 | 1.00 | 30.39 | | C |
| ANISOU | 3966 | CA | TYR | B | 139 | 4246 | 3107 | 4194 | 1197 | 665 | 195 | C |
| ATOM | 3967 | C | TYR | B | 139 | 3.342 | 47.306 | 14.506 | 1.00 | 38.97 | | C |
| ANISOU | 3967 | C | TYR | B | 139 | 5335 | 4088 | 5385 | 1448 | 825 | 243 | C |
| ATOM | 3968 | O | TYR | B | 139 | 3.480 | 46.566 | 13.521 | 1.00 | 34.71 | | O |
| ANISOU | 3968 | O | TYR | B | 139 | 5036 | 3336 | 4815 | 1556 | 940 | 122 | O |
| ATOM | 3969 | CB | TYR | B | 139 | 1.039 | 47.985 | 15.110 | 1.00 | 29.65 | | C |
| ANISOU | 3969 | CB | TYR | B | 139 | 4215 | 2897 | 4155 | 1058 | 484 | 223 | C |
| ATOM | 3970 | CG | TYR | B | 139 | 0.023 | 49.055 | 15.352 | 1.00 | 27.54 | | C |
| ANISOU | 3970 | CG | TYR | B | 139 | 3882 | 2761 | 3819 | 851 | 322 | 203 | C |
| ATOM | 3971 | CD1 | TYR | B | 139 | 0.117 | 49.894 | 16.457 | 1.00 | 26.06 | | C |
| ANISOU | 3971 | CD1 | TYR | B | 139 | 3443 | 2810 | 3651 | 801 | 265 | 308 | C |
| ATOM | 3972 | CD2 | TYR | B | 139 | −1.066 | 49.200 | 14.506 | 1.00 | 33.14 | | C |
| ANISOU | 3972 | CD2 | TYR | B | 139 | 4782 | 3364 | 4444 | 720 | 214 | 71 | C |
| ATOM | 3973 | CE1 | TYR | B | 139 | −0.836 | 50.863 | 16.706 | 1.00 | 24.46 | | C |
| ANISOU | 3973 | CE1 | TYR | B | 139 | 3191 | 2708 | 3395 | 643 | 133 | 280 | C |
| ATOM | 3974 | CE2 | TYR | B | 139 | −2.034 | 50.177 | 14.742 | 1.00 | 31.04 | | C |
| ANISOU | 3974 | CE2 | TYR | B | 139 | 4440 | 3223 | 4131 | 568 | 65 | 63 | C |
| ATOM | 3975 | CZ | TYR | B | 139 | −1.910 | 50.997 | 15.844 | 1.00 | 28.09 | | C |
| ANISOU | 3975 | CZ | TYR | B | 139 | 3826 | 3056 | 3791 | 540 | 39 | 167 | C |
| ATOM | 3976 | OH | TYR | B | 139 | −2.863 | 51.953 | 16.079 | 1.00 | 30.32 | | O |
| ANISOU | 3976 | OH | TYR | B | 139 | 4044 | 3442 | 4035 | 423 | −89 | 146 | O |
| ATOM | 3977 | N | CYS | B | 140 | 4.006 | 47.150 | 15.650 | 1.00 | 37.42 | | N |
| ANISOU | 3977 | N | CYS | B | 140 | 4880 | 4039 | 5299 | 1556 | 822 | 414 | N |
| ATOM | 3978 | CA | CYS | B | 140 | 5.015 | 46.117 | 15.836 | 1.00 | 35.61 | | C |
| ANISOU | 3978 | CA | CYS | B | 140 | 4602 | 3742 | 5187 | 1839 | 957 | 501 | C |
| ATOM | 3979 | C | CYS | B | 140 | 4.475 | 44.729 | 15.524 | 1.00 | 40.92 | | C |
| ANISOU | 3979 | C | CYS | B | 140 | 5584 | 4031 | 5933 | 1923 | 979 | 464 | C |
| ATOM | 3980 | O | CYS | B | 140 | 5.205 | 43.892 | 14.994 | 1.00 | 40.06 | | O |
| ANISOU | 3980 | O | CYS | B | 140 | 5581 | 3760 | 5881 | 2165 | 1147 | 427 | O |
| ATOM | 3981 | CB | CYS | B | 140 | 5.566 | 46.143 | 17.265 | 1.00 | 35.70 | | C |
| ANISOU | 3981 | CB | CYS | B | 140 | 4297 | 3985 | 5282 | 1924 | 881 | 715 | C |
| ATOM | 3982 | SG | CYS | B | 140 | 6.825 | 47.420 | 17.564 | 1.00 | 63.00 | | S |
| ANISOU | 3982 | SG | CYS | B | 140 | 7346 | 7879 | 8714 | 1926 | 918 | 742 | S |
| ATOM | 3983 | N | GLU | B | 141 | 3.203 | 44.490 | 15.840 | 1.00 | 41.23 | | N |
| ANISOU | 3983 | N | GLU | B | 141 | 5765 | 3918 | 5983 | 1720 | 821 | 463 | N |
| ATOM | 3984 | CA | GLU | B | 141 | 2.588 | 43.179 | 15.592 | 1.00 | 46.41 | | C |
| ANISOU | 3984 | CA | GLU | B | 141 | 6719 | 4178 | 6735 | 1735 | 827 | 420 | C |
| ATOM | 3985 | C | GLU | B | 141 | 2.498 | 42.846 | 14.097 | 1.00 | 48.51 | | C |
| ANISOU | 3985 | C | GLU | B | 141 | 7298 | 4213 | 6918 | 1748 | 919 | 156 | C |
| ATOM | 3986 | O | GLU | B | 141 | 2.396 | 41.666 | 13.731 | 1.00 | 44.03 | | O |
| ANISOU | 3986 | O | GLU | B | 141 | 6996 | 3294 | 6440 | 1836 | 982 | 81 | O |
| ATOM | 3987 | CB | GLU | B | 141 | 1.193 | 43.105 | 16.210 | 1.00 | 37.34 | | C |
| ANISOU | 3987 | CB | GLU | B | 141 | 5611 | 2955 | 5619 | 1464 | 644 | 468 | C |
| ATOM | 3988 | CG | GLU | B | 141 | 0.204 | 44.010 | 15.532 | 1.00 | 35.34 | | C |
| ANISOU | 3988 | CG | GLU | B | 141 | 5409 | 2788 | 5231 | 1203 | 518 | 293 | C |
| ATOM | 3989 | CD | GLU | B | 141 | −1.130 | 44.045 | 16.224 | 1.00 | 36.88 | | C |
| ANISOU | 3989 | CD | GLU | B | 141 | 5563 | 2979 | 5471 | 950 | 350 | 352 | C |
| ATOM | 3990 | OE1 | GLU | B | 141 | −1.189 | 43.749 | 17.436 | 1.00 | 41.12 | | O |
| ANISOU | 3990 | OE1 | GLU | B | 141 | 5962 | 3564 | 6100 | 960 | 335 | 564 | O |
| ATOM | 3991 | OE2 | GLU | B | 141 | −2.127 | 44.380 | 15.555 | 1.00 | 38.75 | | O |
| ANISOU | 3991 | OE2 | GLU | B | 141 | 5896 | 3187 | 5640 | 749 | 233 | 193 | O |
| ATOM | 3992 | N | GLY | B | 142 | 2.538 | 43.879 | 13.244 | 1.00 | 38.66 | | N |
| ANISOU | 3992 | N | GLY | B | 142 | 6044 | 3152 | 5492 | 1662 | 928 | 17 | N |
| ATOM | 3993 | CA | GLY | B | 142 | 2.519 | 43.699 | 11.800 | 1.00 | 40.25 | | C |
| ANISOU | 3993 | CA | GLY | B | 142 | 6542 | 3202 | 5550 | 1686 | 1018 | −227 | C |
| ATOM | 3994 | C | GLY | B | 142 | 1.351 | 44.351 | 11.070 | 1.00 | 46.31 | | C |
| ANISOU | 3994 | C | GLY | B | 142 | 7461 | 3990 | 6144 | 1420 | 844 | −385 | C |
| ATOM | 3995 | O | GLY | B | 142 | 1.294 | 44.333 | 9.846 | 1.00 | 55.74 | | O |
| ANISOU | 3995 | O | GLY | B | 142 | 8906 | 5109 | 7164 | 1430 | 892 | −587 | O |
| ATOM | 3996 | N | SER | B | 143 | 0.414 | 44.915 | 11.821 | 1.00 | 36.63 | | N |
| ANISOU | 3996 | N | SER | B | 143 | 6083 | 2880 | 4953 | 1203 | 642 | −292 | N |
| ATOM | 3997 | CA | SER | B | 143 | −0.732 | 45.613 | 11.251 | 1.00 | 46.36 | | C |
| ANISOU | 3997 | CA | SER | B | 143 | 7401 | 4172 | 6043 | 974 | 454 | −410 | C |
| ATOM | 3998 | C | SER | B | 143 | −0.361 | 46.970 | 10.620 | 1.00 | 46.48 | | C |
| ANISOU | 3998 | C | SER | B | 143 | 7359 | 4442 | 5859 | 979 | 493 | −426 | C |
| ATOM | 3999 | O | SER | B | 143 | 0.309 | 47.807 | 11.236 | 1.00 | 38.56 | | O |
| ANISOU | 3999 | O | SER | B | 143 | 6107 | 3658 | 4885 | 1019 | 560 | −282 | O |
| ATOM | 4000 | CB | SER | B | 143 | −1.788 | 45.855 | 12.331 | 1.00 | 44.52 | | C |
| ANISOU | 4000 | CB | SER | B | 143 | 6979 | 4014 | 5924 | 775 | 259 | −289 | C |
| ATOM | 4001 | OG | SER | B | 143 | −2.025 | 44.712 | 13.116 | 1.00 | 56.77 | | O |
| ANISOU | 4001 | OG | SER | B | 143 | 8541 | 5358 | 7672 | 764 | 256 | −203 | O |
| ATOM | 4002 | N | GLN | B | 144 | −0.842 | 47.198 | 9.406 | 1.00 | 50.71 | | N |
| ANISOU | 4002 | N | GLN | B | 144 | 8136 | 4943 | 6188 | 923 | 439 | −599 | N |
| ATOM | 4003 | CA | GLN | B | 144 | −0.753 | 48.511 | 8.772 | 1.00 | 42.10 | | C |
| ANISOU | 4003 | CA | GLN | B | 144 | 7039 | 4061 | 4895 | 897 | 445 | −590 | C |
| ATOM | 4004 | C | GLN | B | 144 | −2.158 | 49.066 | 8.680 | 1.00 | 35.12 | | C |
| ANISOU | 4004 | C | GLN | B | 144 | 6175 | 3226 | 3945 | 705 | 171 | −627 | C |
| ATOM | 4005 | O | GLN | B | 144 | −3.002 | 48.468 | 8.016 | 1.00 | 38.88 | | O |
| ANISOU | 4005 | O | GLN | B | 144 | 6859 | 3573 | 4342 | 627 | 24 | −788 | O |
| ATOM | 4006 | CB | GLN | B | 144 | −0.137 | 48.429 | 7.370 | 1.00 | 50.51 | | C |
| ANISOU | 4006 | CB | GLN | B | 144 | 8378 | 5092 | 5722 | 1021 | 615 | −732 | C |
| ATOM | 4007 | CG | GLN | B | 144 | 1.046 | 47.494 | 7.215 | 1.00 | 66.83 | | C |
| ANISOU | 4007 | CG | GLN | B | 144 | 10497 | 7046 | 7848 | 1240 | 882 | −769 | C |
| ATOM | 4008 | CD | GLN | B | 144 | 2.364 | 48.155 | 7.542 | 1.00 | 76.33 | | C |
| ANISOU | 4008 | CD | GLN | B | 144 | 11446 | 8451 | 9103 | 1365 | 1120 | −611 | C |
| ATOM | 4009 | OE1 | GLN | B | 144 | 2.978 | 47.866 | 8.569 | 1.00 | 81.98 | | O |
| ANISOU | 4009 | OE1 | GLN | B | 144 | 11908 | 9202 | 10041 | 1444 | 1178 | −480 | O |
| ATOM | 4010 | NE2 | GLN | B | 144 | 2.815 | 49.042 | 6.659 | 1.00 | 75.44 | | N |
| ANISOU | 4010 | NE2 | GLN | B | 144 | 11399 | 8484 | 8781 | 1378 | 1259 | −615 | N |
| ATOM | 4011 | N | ILE | B | 145 | −2.410 | 50.191 | 9.347 | 1.00 | 36.68 | | N |
| ANISOU | 4011 | N | ILE | B | 145 | 6151 | 3608 | 4179 | 633 | 96 | −491 | N |
| ATOM | 4012 | CA | ILE | B | 145 | −3.719 | 50.842 | 9.333 | 1.00 | 30.12 | | C |
| ANISOU | 4012 | CA | ILE | B | 145 | 5292 | 2850 | 3301 | 492 | −152 | −505 | C |
| ATOM | 4013 | C | ILE | B | 145 | −3.655 | 52.211 | 8.658 | 1.00 | 37.40 | | C |
| ANISOU | 4013 | C | ILE | B | 145 | 6268 | 3912 | 4031 | 515 | −150 | −466 | C |
| ATOM | 4014 | O | ILE | B | 145 | −2.787 | 53.020 | 8.979 | 1.00 | 34.94 | | O |
| ANISOU | 4014 | O | ILE | B | 145 | 5840 | 3694 | 3741 | 562 | 6 | −352 | O |
| ATOM | 4015 | CB | ILE | B | 145 | −4.268 | 51.014 | 10.778 | 1.00 | 30.81 | | C |
| ANISOU | 4015 | CB | ILE | B | 145 | 5087 | 3016 | 3604 | 399 | −247 | −381 | C |
| ATOM | 4016 | CG1 | ILE | B | 145 | −4.202 | 49.680 | 11.533 | 1.00 | 31.23 | | C |
| ANISOU | 4016 | CG1 | ILE | B | 145 | 5095 | 2923 | 3849 | 388 | −211 | −362 | C |
| ATOM | 4017 | CG2 | ILE | B | 145 | −5.701 | 51.504 | 10.763 | 1.00 | 27.90 | | C |
| ANISOU | 4017 | CG2 | ILE | B | 145 | 4668 | 2719 | 3216 | 273 | −493 | −411 | C |
| ATOM | 4018 | CD1 | ILE | B | 145 | −5.015 | 48.590 | 10.897 | 1.00 | 30.93 | | C |
| ANISOU | 4018 | CD1 | ILE | B | 145 | 5257 | 2682 | 3812 | 296 | −327 | −518 | C |
| ATOM | 4019 | N | SER | B | 146 | −4.553 | 52.471 | 7.713 | 1.00 | 39.20 | | N |
| ANISOU | 4019 | N | SER | B | 146 | 6675 | 4148 | 4071 | 479 | −328 | −556 | N |
| ATOM | 4020 | CA | SER | B | 146 | −4.579 | 53.772 | 7.059 | 1.00 | 36.48 | | C |
| ANISOU | 4020 | CA | SER | B | 146 | 6412 | 3913 | 3536 | 518 | −338 | −486 | C |
| ATOM | 4021 | C | SER | B | 146 | −5.983 | 54.377 | 6.932 | 1.00 | 36.89 | | C |
| ANISOU | 4021 | C | SER | B | 146 | 6440 | 4040 | 3536 | 459 | −630 | −491 | C |
| ATOM | 4022 | O | SER | B | 146 | −6.993 | 53.680 | 7.018 | 1.00 | 38.01 | | O |
| ANISOU | 4022 | O | SER | B | 146 | 6544 | 4164 | 3735 | 373 | −840 | −592 | O |
| ATOM | 4023 | CB | SER | B | 146 | −3.933 | 53.681 | 5.683 | 1.00 | 39.98 | | C |
| ANISOU | 4023 | CB | SER | B | 146 | 7166 | 4328 | 3698 | 615 | −199 | −555 | C |
| ATOM | 4024 | OG | SER | B | 146 | −4.666 | 52.829 | 4.837 | 1.00 | 49.90 | | O |
| ANISOU | 4024 | OG | SER | B | 146 | 8644 | 5518 | 4796 | 595 | −370 | −741 | O |
| ATOM | 4025 | N | GLY | B | 147 | −6.024 | 55.692 | 6.732 | 1.00 | 36.62 | | N |
| ANISOU | 4025 | N | GLY | B | 147 | 6417 | 4087 | 3410 | 508 | −634 | −374 | N |
| ATOM | 4026 | CA | GLY | B | 147 | −7.260 | 56.416 | 6.510 | 1.00 | 31.30 | | C |
| ANISOU | 4026 | CA | GLY | B | 147 | 5730 | 3494 | 2670 | 513 | −894 | −353 | C |
| ATOM | 4027 | C | GLY | B | 147 | −6.993 | 57.911 | 6.434 | 1.00 | 39.25 | | C |
| ANISOU | 4027 | C | GLY | B | 147 | 6766 | 4528 | 3618 | 592 | −818 | −190 | C |
| ATOM | 4028 | O | GLY | B | 147 | −6.000 | 58.340 | 5.848 | 1.00 | 40.62 | | O |
| ANISOU | 4028 | O | GLY | B | 147 | 7110 | 4665 | 3659 | 640 | −606 | −120 | O |
| ATOM | 4029 | N | PHE | B | 148 | −7.886 | 58.707 | 7.014 | 1.00 | 40.22 | | N |
| ANISOU | 4029 | N | PHE | B | 148 | 6727 | 4706 | 3849 | 606 | −976 | −129 | N |
| ATOM | 4030 | CA | PHE | B | 148 | −7.728 | 60.156 | 7.037 | 1.00 | 36.96 | | C |
| ANISOU | 4030 | CA | PHE | B | 148 | 6353 | 4271 | 3420 | 683 | −913 | 19 | C |
| ATOM | 4031 | C | PHE | B | 148 | −7.977 | 60.687 | 8.438 | 1.00 | 37.85 | | C |
| ANISOU | 4031 | C | PHE | B | 148 | 6182 | 4400 | 3800 | 651 | −909 | 48 | C |
| ATOM | 4032 | O | PHE | B | 148 | −8.559 | 59.990 | 9.278 | 1.00 | 32.94 | | O |
| ANISOU | 4032 | O | PHE | B | 148 | 5335 | 3845 | 3337 | 588 | −1004 | −28 | O |
| ATOM | 4033 | CB | PHE | B | 148 | −8.672 | 60.844 | 6.047 | 1.00 | 33.39 | | C |
| ANISOU | 4033 | CB | PHE | B | 148 | 6076 | 3856 | 2755 | 808 | −1130 | 74 | C |
| ATOM | 4034 | CG | PHE | B | 148 | −10.133 | 60.621 | 6.331 | 1.00 | 41.88 | | C |
| ANISOU | 4034 | CG | PHE | B | 148 | 6960 | 5045 | 3907 | 825 | −1439 | 5 | C |
| ATOM | 4035 | CD1 | PHE | B | 148 | −10.821 | 61.455 | 7.209 | 1.00 | 41.37 | | C |
| ANISOU | 4035 | CD1 | PHE | B | 148 | 6679 | 5009 | 4031 | 881 | −1511 | 64 | C |
| ATOM | 4036 | CD2 | PHE | B | 148 | −10.833 | 59.596 | 5.696 | 1.00 | 47.97 | | C |
| ANISOU | 4036 | CD2 | PHE | B | 148 | 7763 | 5900 | 4565 | 781 | −1655 | −133 | C |
| ATOM | 4037 | CE1 | PHE | B | 148 | −12.174 | 61.253 | 7.469 | 1.00 | 39.75 | | C |
| ANISOU | 4037 | CE1 | PHE | B | 148 | 6255 | 4940 | 3909 | 904 | −1774 | 7 | C |
| ATOM | 4038 | CE2 | PHE | B | 148 | −12.193 | 59.386 | 5.943 | 1.00 | 43.61 | | C |
| ANISOU | 4038 | CE2 | PHE | B | 148 | 6989 | 5477 | 4105 | 769 | −1942 | −197 | C |
| ATOM | 4039 | CZ | PHE | B | 148 | −12.860 | 60.213 | 6.831 | 1.00 | 45.78 | | C |
| ANISOU | 4039 | CZ | PHE | B | 148 | 7014 | 5805 | 4575 | 836 | −1993 | −117 | C |
| ATOM | 4040 | N | TYR | B | 149 | −7.503 | 61.910 | 8.677 | 1.00 | 32.91 | | N |
| ANISOU | 4040 | N | TYR | B | 149 | 5586 | 3704 | 3214 | 684 | −783 | 154 | N |
| ATOM | 4041 | CA | TYR | B | 149 | −7.634 | 62.589 | 9.962 | 1.00 | 35.61 | | C |
| ANISOU | 4041 | CA | TYR | B | 149 | 5707 | 4047 | 3777 | 663 | −758 | 160 | C |
| ATOM | 4042 | C | TYR | B | 149 | −8.868 | 63.483 | 10.019 | 1.00 | 38.25 | | C |
| ANISOU | 4042 | C | TYR | B | 149 | 6014 | 4390 | 4130 | 792 | −947 | 194 | C |
| ATOM | 4043 | O | TYR | B | 149 | −9.276 | 64.063 | 9.014 | 1.00 | 41.38 | | O |
| ANISOU | 4043 | O | TYR | B | 149 | 6613 | 4743 | 4365 | 912 | −1040 | 274 | O |
| ATOM | 4044 | CB | TYR | B | 149 | −6.407 | 63.457 | 10.248 | 1.00 | 33.93 | | C |
| ANISOU | 4044 | CB | TYR | B | 149 | 5538 | 3729 | 3624 | 605 | −517 | 226 | C |
| ATOM | 4045 | CG | TYR | B | 149 | −5.255 | 62.747 | 10.901 | 1.00 | 36.99 | | C |
| ANISOU | 4045 | CG | TYR | B | 149 | 5782 | 4160 | 4112 | 482 | −341 | 180 | C |
| ATOM | 4046 | CD1 | TYR | B | 149 | −5.279 | 62.438 | 12.262 | 1.00 | 29.67 | | C |
| ANISOU | 4046 | CD1 | TYR | B | 149 | 4591 | 3319 | 3362 | 423 | −355 | 114 | C |
| ATOM | 4047 | CD2 | TYR | B | 149 | −4.123 | 62.403 | 10.161 | 1.00 | 36.61 | | C |
| ANISOU | 4047 | CD2 | TYR | B | 149 | 5855 | 4084 | 3970 | 446 | −152 | 212 | C |
| ATOM | 4048 | CE1 | TYR | B | 149 | −4.216 | 61.789 | 12.865 | 1.00 | 32.57 | | C |
| ANISOU | 4048 | CE1 | TYR | B | 149 | 4820 | 3746 | 3809 | 340 | −218 | 93 | C |
| ATOM | 4049 | CE2 | TYR | B | 149 | −3.053 | 61.760 | 10.755 | 1.00 | 34.06 | | C |
| ANISOU | 4049 | CE2 | TYR | B | 149 | 5370 | 3819 | 3751 | 367 | 2 | 179 | C |
| ATOM | 4050 | CZ | TYR | B | 149 | −3.107 | 61.449 | 12.101 | 1.00 | 33.38 | | C |
| ANISOU | 4050 | CZ | TYR | B | 149 | 5023 | 3819 | 3840 | 320 | −47 | 125 | C |
| ATOM | 4051 | OH | TYR | B | 149 | −2.040 | 60.811 | 12.686 | 1.00 | 35.10 | | O |
| ANISOU | 4051 | OH | TYR | B | 149 | 5076 | 4112 | 4148 | 271 | 83 | 113 | O |
| ATOM | 4052 | N | PHE | B | 150 | −9.441 | 63.611 | 11.207 | 1.00 | 31.30 | | N |
| ANISOU | 4052 | N | PHE | B | 150 | 4883 | 3575 | 3434 | 788 | −993 | 140 | N |
| ATOM | 4053 | CA | PHE | B | 150 | −10.462 | 64.614 | 11.450 | 1.00 | 34.57 | | C |
| ANISOU | 4053 | CA | PHE | B | 150 | 5244 | 3986 | 3905 | 937 | −1115 | 167 | C |
| ATOM | 4054 | C | PHE | B | 150 | −10.352 | 65.013 | 12.910 | 1.00 | 39.09 | | C |
| ANISOU | 4054 | C | PHE | B | 150 | 5609 | 4572 | 4670 | 898 | −1012 | 104 | C |
| ATOM | 4055 | O | PHE | B | 150 | −9.760 | 64.287 | 13.708 | 1.00 | 36.87 | | O |
| ANISOU | 4055 | O | PHE | B | 150 | 5188 | 4360 | 4461 | 760 | −913 | 45 | O |
| ATOM | 4056 | CB | PHE | B | 150 | −11.862 | 64.089 | 11.139 | 1.00 | 35.50 | | C |
| ANISOU | 4056 | CB | PHE | B | 150 | 5232 | 4259 | 3997 | 1017 | −1373 | 134 | C |
| ATOM | 4057 | CG | PHE | B | 150 | −12.431 | 63.208 | 12.219 | 1.00 | 35.40 | | C |
| ANISOU | 4057 | CG | PHE | B | 150 | 4902 | 4403 | 4145 | 920 | −1409 | 37 | C |
| ATOM | 4058 | CD1 | PHE | B | 150 | −11.960 | 61.915 | 12.399 | 1.00 | 32.37 | | C |
| ANISOU | 4058 | CD1 | PHE | B | 150 | 4466 | 4058 | 3776 | 748 | −1355 | −20 | C |
| ATOM | 4059 | CD2 | PHE | B | 150 | −13.422 | 63.679 | 13.070 | 1.00 | 32.67 | | C |
| ANISOU | 4059 | CD2 | PHE | B | 150 | 4320 | 4157 | 3937 | 1012 | −1472 | 13 | C |
| ATOM | 4060 | CE1 | PHE | B | 150 | −12.478 | 61.090 | 13.399 | 1.00 | 29.02 | | C |
| ANISOU | 4060 | CE1 | PHE | B | 150 | 3773 | 3756 | 3496 | 650 | −1369 | −74 | C |
| ATOM | 4061 | CE2 | PHE | B | 150 | −13.940 | 62.863 | 14.074 | 1.00 | 36.57 | | C |
| ANISOU | 4061 | CE2 | PHE | B | 150 | 4524 | 4807 | 4563 | 911 | −1471 | −53 | C |
| ATOM | 4062 | CZ | PHE | B | 150 | −13.467 | 61.563 | 14.232 | 1.00 | 31.38 | | C |
| ANISOU | 4062 | CZ | PHE | B | 150 | 3834 | 4174 | 3916 | 720 | −1421 | −85 | C |
| ATOM | 4063 | N | SER | B | 151 | −10.927 | 66.157 | 13.267 | 1.00 | 27.79 | | N |
| ANISOU | 4063 | N | SER | B | 151 | 4170 | 3078 | 3311 | 1036 | −1037 | 114 | N |
| ATOM | 4064 | CA | SER | B | 151 | −11.015 | 66.520 | 14.673 | 1.00 | 27.06 | | C |
| ANISOU | 4064 | CA | SER | B | 151 | 3883 | 3025 | 3373 | 1022 | −960 | 21 | C |
| ATOM | 4065 | C | SER | B | 151 | −12.462 | 66.561 | 15.140 | 1.00 | 32.08 | | C |
| ANISOU | 4065 | C | SER | B | 151 | 4300 | 3808 | 4080 | 1172 | −1102 | −20 | C |
| ATOM | 4066 | O | SER | B | 151 | −13.379 | 66.835 | 14.360 | 1.00 | 29.73 | | O |
| ANISOU | 4066 | O | SER | B | 151 | 4033 | 3522 | 3739 | 1337 | −1264 | 39 | O |
| ATOM | 4067 | CB | SER | B | 151 | −10.337 | 67.871 | 14.926 | 1.00 | 27.86 | | C |
| ANISOU | 4067 | CB | SER | B | 151 | 4151 | 2908 | 3528 | 1040 | −818 | 21 | C |
| ATOM | 4068 | OG | SER | B | 151 | −10.967 | 68.898 | 14.171 | 1.00 | 34.60 | | O |
| ANISOU | 4068 | OG | SER | B | 151 | 5187 | 3604 | 4355 | 1242 | −893 | 110 | O |
| ATOM | 4069 | N | ASP | B | 152 | −12.653 | 66.292 | 16.428 | 1.00 | 33.61 | | N |
| ANISOU | 4069 | N | ASP | B | 152 | 4260 | 4137 | 4373 | 1121 | −1039 | −113 | N |
| ATOM | 4070 | CA | ASP | B | 152 | −13.970 | 66.310 | 17.031 | 1.00 | 28.17 | | C |
| ANISOU | 4070 | CA | ASP | B | 152 | 3320 | 3618 | 3764 | 1249 | −1122 | −157 | C |
| ATOM | 4071 | C | ASP | B | 152 | −13.833 | 66.375 | 18.536 | 1.00 | 36.65 | | C |
| ANISOU | 4071 | C | ASP | B | 152 | 4228 | 4790 | 4909 | 1201 | −977 | −260 | C |
| ATOM | 4072 | O | ASP | B | 152 | −12.740 | 66.259 | 19.079 | 1.00 | 37.59 | | O |
| ANISOU | 4072 | O | ASP | B | 152 | 4408 | 4869 | 5006 | 1054 | −852 | −296 | O |
| ATOM | 4073 | CB | ASP | B | 152 | −14.785 | 65.079 | 16.630 | 1.00 | 28.27 | | C |
| ANISOU | 4073 | CB | ASP | B | 152 | 3150 | 3824 | 3769 | 1186 | −1272 | −131 | C |
| ATOM | 4074 | CG | ASP | B | 152 | −16.288 | 65.353 | 16.593 | 1.00 | 40.58 | | C |
| ANISOU | 4074 | CG | ASP | B | 152 | 4487 | 5534 | 5397 | 1370 | −1421 | −134 | C |
| ATOM | 4075 | OD1 | ASP | B | 152 | −16.774 | 66.213 | 17.366 | 1.00 | 39.39 | | O |
| ANISOU | 4075 | OD1 | ASP | B | 152 | 4232 | 5407 | 5327 | 1532 | −1355 | −180 | O |
| ATOM | 4076 | OD2 | ASP | B | 152 | −16.988 | 64.705 | 15.788 | 1.00 | 31.52 | | O |
| ANISOU | 4076 | OD2 | ASP | B | 152 | 3260 | 4492 | 4223 | 1355 | −1608 | −103 | O |
| ATOM | 4077 | N | VAL | B | 153 | −14.957 | 66.573 | 19.208 | 1.00 | 38.85 | | N |
| ANISOU | 4077 | N | VAL | B | 153 | 4284 | 5220 | 5256 | 1335 | −995 | −309 | N |
| ATOM | 4078 | CA | VAL | B | 153 | −14.984 | 66.605 | 20.653 | 1.00 | 37.22 | | C |
| ANISOU | 4078 | CA | VAL | B | 153 | 3915 | 5148 | 5077 | 1312 | −854 | −410 | C |
| ATOM | 4079 | C | VAL | B | 153 | −14.823 | 65.207 | 21.242 | 1.00 | 33.26 | | C |
| ANISOU | 4079 | C | VAL | B | 153 | 3238 | 4845 | 4553 | 1106 | −817 | −377 | C |
| ATOM | 4080 | O | VAL | B | 153 | −15.493 | 64.263 | 20.827 | 1.00 | 34.15 | | O |
| ANISOU | 4080 | O | VAL | B | 153 | 3207 | 5072 | 4695 | 1048 | −911 | −308 | O |
| ATOM | 4081 | CB | VAL | B | 153 | −16.296 | 67.217 | 21.146 | 1.00 | 40.13 | | C |
| ANISOU | 4081 | CB | VAL | B | 153 | 4088 | 5639 | 5522 | 1543 | −858 | −467 | C |
| ATOM | 4082 | CG1 | VAL | B | 153 | −16.360 | 67.156 | 22.638 | 1.00 | 46.83 | | C |
| ANISOU | 4082 | CG1 | VAL | B | 153 | 4775 | 6661 | 6357 | 1518 | −694 | −573 | C |
| ATOM | 4083 | CG2 | VAL | B | 153 | −16.379 | 68.634 | 20.694 | 1.00 | 35.35 | | C |
| ANISOU | 4083 | CG2 | VAL | B | 153 | 3685 | 4796 | 4950 | 1772 | −873 | −496 | C |
| ATOM | 4084 | N | VAL | B | 154 | −13.905 | 65.085 | 22.188 | 1.00 | 30.42 | | N |
| ANISOU | 4084 | N | VAL | B | 154 | 2905 | 4512 | 4142 | 993 | −689 | −424 | N |
| ATOM | 4085 | CA | VAL | B | 154 | −13.763 | 63.882 | 23.005 | 1.00 | 31.11 | | C |
| ANISOU | 4085 | CA | VAL | B | 154 | 2833 | 4789 | 4197 | 839 | −627 | −378 | C |
| ATOM | 4086 | C | VAL | B | 154 | −14.145 | 64.164 | 24.465 | 1.00 | 34.56 | | C |
| ANISOU | 4086 | C | VAL | B | 154 | 3115 | 5422 | 4594 | 894 | −500 | −460 | C |
| ATOM | 4087 | O | VAL | B | 154 | −13.732 | 65.173 | 25.031 | 1.00 | 40.96 | | O |
| ANISOU | 4087 | O | VAL | B | 154 | 4022 | 6181 | 5359 | 965 | −433 | −587 | O |
| ATOM | 4088 | CB | VAL | B | 154 | −12.328 | 63.336 | 22.922 | 1.00 | 29.56 | | C |
| ANISOU | 4088 | CB | VAL | B | 154 | 2778 | 4511 | 3942 | 679 | −595 | −338 | C |
| ATOM | 4089 | CG1 | VAL | B | 154 | −12.091 | 62.304 | 23.975 | 1.00 | 43.16 | | C |
| ANISOU | 4089 | CG1 | VAL | B | 154 | 4364 | 6417 | 5618 | 569 | −518 | −284 | C |
| ATOM | 4090 | CG2 | VAL | B | 154 | −12.077 | 62.763 | 21.535 | 1.00 | 32.79 | | C |
| ANISOU | 4090 | CG2 | VAL | B | 154 | 3313 | 4775 | 4369 | 622 | −692 | −254 | C |
| ATOM | 4091 | N | SER | B | 155 | −14.984 | 63.315 | 25.045 | 1.00 | 36.17 | | N |
| ANISOU | 4091 | N | SER | B | 155 | 3088 | 5844 | 4812 | 858 | −460 | −395 | N |
| ATOM | 4092 | CA | SER | B | 155 | −15.331 | 63.416 | 26.464 | 1.00 | 44.04 | | C |
| ANISOU | 4092 | CA | SER | B | 155 | 3938 | 7065 | 5730 | 898 | −310 | −448 | C |
| ATOM | 4093 | C | SER | B | 155 | −15.026 | 62.131 | 27.223 | 1.00 | 41.95 | | C |
| ANISOU | 4093 | C | SER | B | 155 | 3585 | 6961 | 5393 | 727 | −234 | −319 | C |
| ATOM | 4094 | O | SER | B | 155 | −15.549 | 61.077 | 26.896 | 1.00 | 43.90 | | O |
| ANISOU | 4094 | O | SER | B | 155 | 3711 | 7247 | 5720 | 620 | −260 | −185 | O |
| ATOM | 4095 | CB | SER | B | 155 | −16.815 | 63.750 | 26.661 | 1.00 | 50.25 | | C |
| ANISOU | 4095 | CB | SER | B | 155 | 4491 | 8008 | 6593 | 1054 | −273 | −478 | C |
| ATOM | 4096 | OG | SER | B | 155 | −17.208 | 64.892 | 25.925 | 1.00 | 65.99 | | O |
| ANISOU | 4096 | OG | SER | B | 155 | 6559 | 9849 | 8665 | 1254 | −354 | −568 | O |
| ATOM | 4097 | N | VAL | B | 156 | −14.163 | 62.186 | 28.218 | 1.00 | 41.41 | | N |
| ANISOU | 4097 | N | VAL | B | 156 | 3585 | 6976 | 5173 | 697 | −152 | −352 | N |
| ATOM | 4098 | CA | VAL | B | 156 | −14.070 | 61.030 | 29.084 | 1.00 | 38.46 | | C |
| ANISOU | 4098 | CA | VAL | B | 156 | 3116 | 6786 | 4713 | 584 | −65 | −202 | C |
| ATOM | 4099 | C | VAL | B | 156 | −14.624 | 61.403 | 30.462 | 1.00 | 39.62 | | C |
| ANISOU | 4099 | C | VAL | B | 156 | 3145 | 7202 | 4707 | 672 | 94 | −264 | C |
| ATOM | 4100 | O | VAL | B | 156 | −14.398 | 62.502 | 30.967 | 1.00 | 33.98 | | O |
| ANISOU | 4100 | O | VAL | B | 156 | 2508 | 6512 | 3891 | 788 | 124 | −455 | O |
| ATOM | 4101 | CB | VAL | B | 156 | −12.650 | 60.448 | 29.151 | 1.00 | 39.55 | | C |
| ANISOU | 4101 | CB | VAL | B | 156 | 3398 | 6858 | 4773 | 479 | −105 | −128 | C |
| ATOM | 4102 | CG1 | VAL | B | 156 | −11.665 | 61.369 | 29.890 | 1.00 | 34.39 | | C |
| ANISOU | 4102 | CG1 | VAL | B | 156 | 2851 | 6256 | 3960 | 525 | −97 | −284 | C |
| ATOM | 4103 | CG2 | VAL | B | 156 | −12.718 | 59.070 | 29.761 | 1.00 | 39.64 | | C |
| ANISOU | 4103 | CG2 | VAL | B | 156 | 3324 | 6996 | 4742 | 376 | −33 | 85 | C |
| ATOM | 4104 | N | VAL | B | 157 | −15.422 | 60.501 | 31.019 | 1.00 | 43.60 | | N |
| ANISOU | 4104 | N | VAL | B | 157 | 3466 | 7896 | 5204 | 614 | 206 | −111 | N |
| ATOM | 4105 | CA | VAL | B | 157 | −16.103 | 60.727 | 32.275 | 1.00 | 40.29 | | C |
| ANISOU | 4105 | CA | VAL | B | 157 | 2912 | 7763 | 4631 | 697 | 393 | −140 | C |
| ATOM | 4106 | C | VAL | B | 157 | −15.631 | 59.701 | 33.292 | 1.00 | 43.12 | | C |
| ANISOU | 4106 | C | VAL | B | 157 | 3280 | 8297 | 4805 | 589 | 494 | 49 | C |
| ATOM | 4107 | O | VAL | B | 157 | −15.631 | 58.504 | 33.012 | 1.00 | 48.31 | | O |
| ANISOU | 4107 | O | VAL | B | 157 | 3904 | 8896 | 5553 | 439 | 486 | 271 | O |
| ATOM | 4108 | CB | VAL | B | 157 | −17.644 | 60.609 | 32.123 | 1.00 | 52.71 | | C |
| ANISOU | 4108 | CB | VAL | B | 157 | 4211 | 9457 | 6358 | 732 | 483 | −98 | C |
| ATOM | 4109 | CG1 | VAL | B | 157 | −18.348 | 60.965 | 33.426 | 1.00 | 38.81 | | C |
| ANISOU | 4109 | CG1 | VAL | B | 157 | 2355 | 7962 | 4430 | 835 | 701 | −146 | C |
| ATOM | 4110 | CG2 | VAL | B | 157 | −18.146 | 61.479 | 30.982 | 1.00 | 50.62 | | C |
| ANISOU | 4110 | CG2 | VAL | B | 157 | 3928 | 9017 | 6288 | 855 | 346 | −236 | C |
| ATOM | 4111 | N | SER | B | 158 | −15.189 | 60.177 | 34.455 | 1.00 | 40.71 | | N |
| ANISOU | 4111 | N | SER | B | 158 | 3045 | 8193 | 4231 | 670 | 578 | −42 | N |
| ATOM | 4112 | CA | SER | B | 158 | −14.774 | 59.302 | 35.542 | 1.00 | 37.18 | | C |
| ANISOU | 4112 | CA | SER | B | 158 | 2616 | 7959 | 3551 | 609 | 674 | 148 | C |
| ATOM | 4113 | C | SER | B | 158 | −16.005 | 58.673 | 36.146 | 1.00 | 47.99 | | C |
| ANISOU | 4113 | C | SER | B | 158 | 3782 | 9546 | 4908 | 581 | 894 | 318 | C |
| ATOM | 4114 | O | SER | B | 158 | −17.106 | 59.121 | 35.857 | 1.00 | 53.95 | | O |
| ANISOU | 4114 | O | SER | B | 158 | 4380 | 10309 | 5808 | 635 | 960 | 230 | O |
| ATOM | 4115 | CB | SER | B | 158 | −13.990 | 60.076 | 36.597 | 1.00 | 38.29 | | C |
| ANISOU | 4115 | CB | SER | B | 158 | 2889 | 8283 | 3375 | 708 | 675 | −30 | C |
| ATOM | 4116 | OG | SER | B | 158 | −14.854 | 60.865 | 37.379 | 1.00 | 40.97 | | O |
| ANISOU | 4116 | OG | SER | B | 158 | 3156 | 8838 | 3573 | 845 | 844 | −198 | O |
| ATOM | 4117 | N | TYR | B | 159 | −15.853 | 57.641 | 36.974 | 1.00 | 51.81 | | N |
| ANISOU | 4117 | N | TYR | B | 159 | 4270 | 10186 | 5229 | 498 | 1007 | 576 | N |
| ATOM | 4118 | CA | TYR | B | 159 | −17.052 | 57.059 | 37.578 | 1.00 | 65.37 | | C |
| ANISOU | 4118 | CA | TYR | B | 159 | 5849 | 12026 | 6963 | 438 | 1211 | 741 | C |
| ATOM | 4119 | C | TYR | B | 159 | −17.444 | 57.789 | 38.863 | 1.00 | 62.86 | | C |
| ANISOU | 4119 | C | TYR | B | 159 | 5556 | 11967 | 6362 | 581 | 1364 | 612 | C |
| ATOM | 4120 | O | TYR | B | 159 | −18.344 | 57.362 | 39.587 | 1.00 | 66.02 | | O |
| ANISOU | 4120 | O | TYR | B | 159 | 5873 | 12487 | 6725 | 546 | 1551 | 742 | O |
| ATOM | 4121 | CB | TYR | B | 159 | −16.926 | 55.549 | 37.824 | 1.00 | 77.70 | | C |
| ANISOU | 4121 | CB | TYR | B | 159 | 7431 | 13554 | 8538 | 265 | 1278 | 1104 | C |
| ATOM | 4122 | CG | TYR | B | 159 | −15.878 | 55.049 | 38.786 | 1.00 | 85.22 | | C |
| ANISOU | 4122 | CG | TYR | B | 159 | 8557 | 14648 | 9176 | 298 | 1290 | 1276 | C |
| ATOM | 4123 | CD1 | TYR | B | 159 | −16.130 | 55.010 | 40.153 | 1.00 | 85.68 | | C |
| ANISOU | 4123 | CD1 | TYR | B | 159 | 8665 | 14945 | 8945 | 359 | 1439 | 1345 | C |
| ATOM | 4124 | CD2 | TYR | B | 159 | −14.684 | 54.499 | 38.318 | 1.00 | 91.55 | | C |
| ANISOU | 4124 | CD2 | TYR | B | 159 | 9489 | 15301 | 9995 | 267 | 1132 | 1390 | C |
| ATOM | 4125 | CE1 | TYR | B | 159 | −15.192 | 54.507 | 41.041 | 1.00 | 92.58 | | C |
| ANISOU | 4125 | CE1 | TYR | B | 159 | 9706 | 15941 | 9530 | 402 | 1412 | 1516 | C |
| ATOM | 4126 | CE2 | TYR | B | 159 | −13.737 | 53.985 | 39.197 | 1.00 | 93.80 | | C |
| ANISOU | 4126 | CE2 | TYR | B | 159 | 9924 | 15717 | 9997 | 319 | 1117 | 1573 | C |
| ATOM | 4127 | CZ | TYR | B | 159 | −13.994 | 53.994 | 40.562 | 1.00 | 94.11 | | C |
| ANISOU | 4127 | CZ | TYR | B | 159 | 10006 | 16017 | 9734 | 389 | 1244 | 1636 | C |
| ATOM | 4128 | OH | TYR | B | 159 | −13.059 | 53.490 | 41.448 | 1.00 | 90.52 | | O |
| ANISOU | 4128 | OH | TYR | B | 159 | 9707 | 15678 | 9011 | 460 | 1185 | 1808 | O |
| ATOM | 4129 | N | ASN | B | 160 | −16.769 | 58.897 | 39.132 | 1.00 | 56.76 | | N |
| ANISOU | 4129 | N | ASN | B | 160 | 4902 | 11265 | 5399 | 733 | 1288 | 340 | N |
| ATOM | 4130 | CA | ASN | B | 160 | −17.246 | 59.841 | 40.125 | 1.00 | 53.61 | | C |
| ANISOU | 4130 | CA | ASN | B | 160 | 4534 | 11047 | 4790 | 887 | 1410 | 128 | C |
| ATOM | 4131 | C | ASN | B | 160 | −17.918 | 60.963 | 39.342 | 1.00 | 53.84 | | C |
| ANISOU | 4131 | C | ASN | B | 160 | 4485 | 10923 | 5050 | 1007 | 1382 | −139 | C |
| ATOM | 4132 | O | ASN | B | 160 | −18.176 | 62.049 | 39.853 | 1.00 | 52.19 | | O |
| ANISOU | 4132 | O | ASN | B | 160 | 4329 | 10773 | 4728 | 1170 | 1442 | −395 | O |
| ATOM | 4133 | CB | ASN | B | 160 | −16.098 | 60.372 | 40.963 | 1.00 | 49.80 | | C |
| ANISOU | 4133 | CB | ASN | B | 160 | 4255 | 10708 | 3957 | 965 | 1328 | −30 | C |
| ATOM | 4134 | CG | ASN | B | 160 | −16.377 | 60.317 | 42.434 | 1.00 | 67.47 | | C |
| ANISOU | 4134 | CG | ASN | B | 160 | 6555 | 13204 | 5875 | 1021 | 1480 | 3 | C |
| ATOM | 4135 | OD1 | ASN | B | 160 | −17.526 | 60.380 | 42.874 | 1.00 | 78.55 | | O |
| ANISOU | 4135 | OD1 | ASN | B | 160 | 7857 | 14686 | 7304 | 1063 | 1681 | 20 | O |
| ATOM | 4136 | ND2 | ASN | B | 160 | −15.318 | 60.203 | 43.218 | 1.00 | 63.94 | | N |
| ANISOU | 4136 | ND2 | ASN | B | 160 | 6271 | 12900 | 5125 | 1026 | 1381 | 10 | N |
| ATOM | 4137 | N | ASN | B | 161 | −18.199 | 60.654 | 38.079 | 1.00 | 53.76 | | N |
| ANISOU | 4137 | N | ASN | B | 161 | 4363 | 10695 | 5369 | 927 | 1281 | −64 | N |
| ATOM | 4138 | CA | ASN | B | 161 | −18.963 | 61.499 | 37.185 | 1.00 | 52.02 | | C |
| ANISOU | 4138 | CA | ASN | B | 161 | 4047 | 10307 | 5409 | 1032 | 1230 | −237 | C |
| ATOM | 4139 | C | ASN | B | 161 | −18.299 | 62.858 | 36.970 | 1.00 | 51.49 | | C |
| ANISOU | 4139 | C | ASN | B | 161 | 4140 | 10137 | 5286 | 1205 | 1128 | −556 | C |
| ATOM | 4140 | O | ASN | B | 161 | −18.960 | 63.858 | 36.745 | 1.00 | 56.72 | | O |
| ANISOU | 4140 | O | ASN | B | 161 | 4781 | 10716 | 6056 | 1372 | 1148 | −744 | O |
| ATOM | 4141 | CB | ASN | B | 161 | −20.383 | 61.628 | 37.729 | 1.00 | 64.12 | | C |
| ANISOU | 4141 | CB | ASN | B | 161 | 5406 | 11966 | 6989 | 1099 | 1427 | −227 | C |
| ATOM | 4142 | CG | ASN | B | 161 | −20.893 | 60.305 | 38.339 | 1.00 | 71.36 | | C |
| ANISOU | 4142 | CG | ASN | B | 161 | 6206 | 13028 | 7879 | 916 | 1583 | 73 | C |
| ATOM | 4143 | OD1 | ASN | B | 161 | −21.185 | 59.351 | 37.611 | 1.00 | 69.29 | | O |
| ANISOU | 4143 | OD1 | ASN | B | 161 | 5830 | 12650 | 7847 | 736 | 1531 | 267 | O |
| ATOM | 4144 | ND2 | ASN | B | 161 | −21.004 | 60.254 | 39.673 | 1.00 | 70.86 | | N |
| ANISOU | 4144 | ND2 | ASN | B | 161 | 6188 | 13201 | 7534 | 958 | 1775 | 102 | N |
| ATOM | 4145 | N | GLU | B | 162 | −16.973 | 62.860 | 36.966 | 1.00 | 50.94 | | N |
| ANISOU | 4145 | N | GLU | B | 162 | 4230 | 10050 | 5075 | 1157 | 1012 | −608 | N |
| ATOM | 4146 | CA | GLU | B | 162 | −16.197 | 64.058 | 36.667 | 1.00 | 46.97 | | C |
| ANISOU | 4146 | CA | GLU | B | 162 | 3925 | 9360 | 4563 | 1248 | 882 | −900 | C |
| ATOM | 4147 | C | GLU | B | 162 | −15.779 | 64.031 | 35.212 | 1.00 | 43.14 | | C |
| ANISOU | 4147 | C | GLU | B | 162 | 3500 | 8523 | 4370 | 1163 | 670 | −848 | C |
| ATOM | 4148 | O | GLU | B | 162 | −15.051 | 63.136 | 34.795 | 1.00 | 45.95 | | O |
| ANISOU | 4148 | O | GLU | B | 162 | 3895 | 8797 | 4766 | 995 | 559 | −662 | O |
| ATOM | 4149 | CB | GLU | B | 162 | −14.962 | 64.146 | 37.565 | 1.00 | 45.80 | | C |
| ANISOU | 4149 | CB | GLU | B | 162 | 3972 | 9319 | 4110 | 1190 | 825 | −989 | C |
| ATOM | 4150 | CG | GLU | B | 162 | −15.273 | 64.125 | 39.057 | 1.00 | 50.89 | | C |
| ANISOU | 4150 | CG | GLU | B | 162 | 4610 | 10320 | 4404 | 1264 | 1010 | −1027 | C |
| ATOM | 4151 | CD | GLU | B | 162 | −14.279 | 63.282 | 39.838 | 1.00 | 55.24 | | C |
| ANISOU | 4151 | CD | GLU | B | 162 | 5238 | 11080 | 4670 | 1146 | 956 | −866 | C |
| ATOM | 4152 | OE1 | GLU | B | 162 | −13.928 | 63.661 | 40.974 | 1.00 | 59.22 | | O |
| ANISOU | 4152 | OE1 | GLU | B | 162 | 5871 | 11750 | 4880 | 1182 | 961 | −996 | O |
| ATOM | 4153 | OE2 | GLU | B | 162 | −13.853 | 62.230 | 39.314 | 1.00 | 55.65 | | O |
| ANISOU | 4153 | OE2 | GLU | B | 162 | 5251 | 11058 | 4836 | 1009 | 870 | −589 | O |
| ATOM | 4154 | N | ARG | B | 163 | −16.235 | 65.009 | 34.437 | 1.00 | 39.28 | | N |
| ANISOU | 4154 | N | ARG | B | 163 | 3031 | 7822 | 4072 | 1297 | 623 | −1007 | N |
| ATOM | 4155 | CA | ARG | B | 163 | −16.054 | 64.965 | 32.990 | 1.00 | 37.85 | | C |
| ANISOU | 4155 | CA | ARG | B | 163 | 2893 | 7337 | 4150 | 1239 | 442 | −932 | C |
| ATOM | 4156 | C | ARG | B | 163 | −14.945 | 65.893 | 32.541 | 1.00 | 38.39 | | C |
| ANISOU | 4156 | C | ARG | B | 163 | 3226 | 7128 | 4233 | 1227 | 311 | −1104 | C |
| ATOM | 4157 | O | ARG | B | 163 | −14.840 | 67.021 | 33.017 | 1.00 | 44.24 | | O |
| ANISOU | 4157 | O | ARG | B | 163 | 4090 | 7819 | 4901 | 1347 | 354 | −1349 | O |
| ATOM | 4158 | CB | ARG | B | 163 | −17.336 | 65.340 | 32.259 | 1.00 | 37.96 | | C |
| ANISOU | 4158 | CB | ARG | B | 163 | 2743 | 7299 | 4382 | 1396 | 452 | −936 | C |
| ATOM | 4159 | CG | ARG | B | 163 | −17.241 | 65.105 | 30.769 | 1.00 | 48.83 | | C |
| ANISOU | 4159 | CG | ARG | B | 163 | 4156 | 8418 | 5980 | 1327 | 257 | −824 | C |
| ATOM | 4160 | CD | ARG | B | 163 | −18.434 | 65.677 | 30.012 | 1.00 | 60.32 | | C |
| ANISOU | 4160 | CD | ARG | B | 163 | 5469 | 9823 | 7629 | 1522 | 221 | −852 | C |
| ATOM | 4161 | NE | ARG | B | 163 | −19.735 | 65.081 | 30.312 | 1.00 | 63.94 | | N |
| ANISOU | 4161 | NE | ARG | B | 163 | 5642 | 10499 | 8152 | 1517 | 316 | −736 | N |
| ATOM | 4162 | CZ | ARG | B | 163 | −20.302 | 64.124 | 29.587 | 1.00 | 64.96 | | C |
| ANISOU | 4162 | CZ | ARG | B | 163 | 5633 | 10618 | 8430 | 1360 | 224 | −551 | C |
| ATOM | 4163 | NH1 | ARG | B | 163 | −19.681 | 63.654 | 28.517 | 1.00 | 61.45 | | N |
| ANISOU | 4163 | NH1 | ARG | B | 163 | 5287 | 10004 | 8059 | 1240 | 40 | −476 | N |
| ATOM | 4164 | NH2 | ARG | B | 163 | −21.493 | 63.646 | 29.928 | 1.00 | 68.94 | | N |
| ANISOU | 4164 | NH2 | ARG | B | 163 | 5906 | 11276 | 9013 | 1318 | 320 | −458 | N |
| ATOM | 4165 | N | VAL | B | 164 | −14.102 | 65.401 | 31.640 | 1.00 | 39.36 | | N |
| ANISOU | 4165 | N | VAL | B | 164 | 3437 | 7067 | 4452 | 1073 | 165 | −981 | N |
| ATOM | 4166 | CA | VAL | B | 164 | −13.097 | 66.224 | 30.976 | 1.00 | 36.07 | | C |
| ANISOU | 4166 | CA | VAL | B | 164 | 3242 | 6365 | 4099 | 1035 | 52 | −1101 | C |
| ATOM | 4167 | C | VAL | B | 164 | −13.287 | 66.108 | 29.471 | 1.00 | 39.83 | | C |
| ANISOU | 4167 | C | VAL | B | 164 | 3747 | 6595 | 4790 | 1027 | −59 | −978 | C |
| ATOM | 4168 | O | VAL | B | 164 | −13.391 | 65.010 | 28.930 | 1.00 | 42.46 | | O |
| ANISOU | 4168 | O | VAL | B | 164 | 3991 | 6961 | 5182 | 930 | −107 | −782 | O |
| ATOM | 4169 | CB | VAL | B | 164 | −11.675 | 65.810 | 31.373 | 1.00 | 35.56 | | C |
| ANISOU | 4169 | CB | VAL | B | 164 | 3263 | 6343 | 3904 | 856 | −6 | −1085 | C |
| ATOM | 4170 | CG1 | VAL | B | 164 | −10.636 | 66.675 | 30.669 | 1.00 | 30.52 | | C |
| ANISOU | 4170 | CG1 | VAL | B | 164 | 2819 | 5421 | 3356 | 784 | −101 | −1204 | C |
| ATOM | 4171 | CG2 | VAL | B | 164 | −11.520 | 65.891 | 32.889 | 1.00 | 33.51 | | C |
| ANISOU | 4171 | CG2 | VAL | B | 164 | 2979 | 6370 | 3383 | 872 | 78 | −1202 | C |
| ATOM | 4172 | N | THR | B | 165 | −13.319 | 67.255 | 28.803 | 1.00 | 43.14 | | N |
| ANISOU | 4172 | N | THR | B | 165 | 4318 | 6759 | 5316 | 1133 | −99 | −1097 | N |
| ATOM | 4173 | CA | THR | B | 165 | −13.759 | 67.336 | 27.413 | 1.00 | 41.05 | | C |
| ANISOU | 4173 | CA | THR | B | 165 | 4086 | 6289 | 5220 | 1191 | −200 | −990 | C |
| ATOM | 4174 | C | THR | B | 165 | −12.834 | 68.231 | 26.599 | 1.00 | 35.26 | | C |
| ANISOU | 4174 | C | THR | B | 165 | 3618 | 5232 | 4549 | 1157 | −260 | −1045 | C |
| ATOM | 4175 | O | THR | B | 165 | −12.404 | 69.285 | 27.059 | 1.00 | 34.09 | | O |
| ANISOU | 4175 | O | THR | B | 165 | 3617 | 4954 | 4381 | 1186 | −211 | −1226 | O |
| ATOM | 4176 | CB | THR | B | 165 | −15.206 | 67.884 | 27.327 | 1.00 | 45.42 | | C |
| ANISOU | 4176 | CB | THR | B | 165 | 4512 | 6880 | 5863 | 1438 | −173 | −1026 | C |
| ATOM | 4177 | OG1 | THR | B | 165 | −16.117 | 66.934 | 27.882 | 1.00 | 57.01 | | O |
| ANISOU | 4177 | OG1 | THR | B | 165 | 5698 | 8654 | 7309 | 1432 | −112 | −934 | O |
| ATOM | 4178 | CG2 | THR | B | 165 | −15.602 | 68.165 | 25.908 | 1.00 | 45.02 | | C |
| ANISOU | 4178 | CG2 | THR | B | 165 | 4527 | 6621 | 5956 | 1529 | −307 | −931 | C |
| ATOM | 4179 | N | PHE | B | 166 | −12.521 | 67.802 | 25.390 | 1.00 | 34.15 | | N |
| ANISOU | 4179 | N | PHE | B | 166 | 3546 | 4953 | 4476 | 1083 | −355 | −894 | N |
| ATOM | 4180 | CA | PHE | B | 166 | −11.650 | 68.579 | 24.532 | 1.00 | 33.99 | | C |
| ANISOU | 4180 | CA | PHE | B | 166 | 3772 | 4635 | 4508 | 1036 | −385 | −906 | C |
| ATOM | 4181 | C | PHE | B | 166 | −11.702 | 68.079 | 23.103 | 1.00 | 33.89 | | C |
| ANISOU | 4181 | C | PHE | B | 166 | 3820 | 4514 | 4543 | 1021 | −483 | −726 | C |
| ATOM | 4182 | O | PHE | B | 166 | −12.081 | 66.922 | 22.837 | 1.00 | 31.33 | | O |
| ANISOU | 4182 | O | PHE | B | 166 | 3354 | 4346 | 4205 | 974 | −538 | −610 | O |
| ATOM | 4183 | CB | PHE | B | 166 | −10.208 | 68.536 | 25.043 | 1.00 | 32.82 | | C |
| ANISOU | 4183 | CB | PHE | B | 166 | 3691 | 4482 | 4295 | 826 | −344 | −972 | C |
| ATOM | 4184 | CG | PHE | B | 166 | −9.710 | 67.157 | 25.342 | 1.00 | 30.77 | | C |
| ANISOU | 4184 | CG | PHE | B | 166 | 3283 | 4450 | 3960 | 683 | −357 | −858 | C |
| ATOM | 4185 | CD2 | PHE | B | 166 | −9.793 | 66.641 | 26.628 | 1.00 | 28.54 | | C |
| ANISOU | 4185 | CD2 | PHE | B | 166 | 2845 | 4437 | 3562 | 662 | −313 | −901 | C |
| ATOM | 4186 | CD1 | PHE | B | 166 | −9.146 | 66.378 | 24.346 | 1.00 | 30.70 | | C |
| ANISOU | 4186 | CD1 | PHE | B | 166 | 3309 | 4376 | 3981 | 586 | −402 | −704 | C |
| ATOM | 4187 | CE2 | PHE | B | 166 | −9.323 | 65.393 | 26.907 | 1.00 | 28.20 | | C |
| ANISOU | 4187 | CE2 | PHE | B | 166 | 2691 | 4569 | 3454 | 554 | −322 | −770 | C |
| ATOM | 4188 | CE1 | PHE | B | 166 | −8.668 | 65.115 | 24.628 | 1.00 | 29.85 | | C |
| ANISOU | 4188 | CE1 | PHE | B | 166 | 3086 | 4437 | 3820 | 482 | −404 | −600 | C |
| ATOM | 4189 | CZ | PHE | B | 166 | −8.759 | 64.623 | 25.907 | 1.00 | 30.66 | | C |
| ANISOU | 4189 | CZ | PHE | B | 166 | 3039 | 4784 | 3826 | 469 | −368 | −621 | C |
| ATOM | 4190 | N | ARG | B | 167 | −11.288 | 68.957 | 22.194 | 1.00 | 31.98 | | N |
| ANISOU | 4190 | N | ARG | B | 167 | 3810 | 3993 | 4347 | 1047 | −497 | −709 | N |
| ATOM | 4191 | CA | ARG | B | 167 | −11.200 | 68.633 | 20.778 | 1.00 | 35.55 | | C |
| ANISOU | 4191 | CA | ARG | B | 167 | 4377 | 4330 | 4799 | 1038 | −579 | −547 | C |
| ATOM | 4192 | C | ARG | B | 167 | −9.875 | 67.909 | 20.532 | 1.00 | 34.88 | | C |
| ANISOU | 4192 | C | ARG | B | 167 | 4337 | 4247 | 4667 | 811 | −537 | −494 | C |
| ATOM | 4193 | O | ARG | B | 167 | −8.846 | 68.318 | 21.065 | 1.00 | 34.58 | | O |
| ANISOU | 4193 | O | ARG | B | 167 | 4347 | 4156 | 4634 | 684 | −450 | −576 | O |
| ATOM | 4194 | CB | ARG | B | 167 | −11.327 | 69.926 | 19.951 | 1.00 | 38.17 | | C |
| ANISOU | 4194 | CB | ARG | B | 167 | 4958 | 4363 | 5182 | 1181 | −588 | −522 | C |
| ATOM | 4195 | CG | ARG | B | 167 | −11.024 | 69.839 | 18.455 | 1.00 | 45.43 | | C |
| ANISOU | 4195 | CG | ARG | B | 167 | 6073 | 5133 | 6057 | 1169 | −646 | −352 | C |
| ATOM | 4196 | CD | ARG | B | 167 | −11.674 | 71.011 | 17.677 | 1.00 | 44.48 | | C |
| ANISOU | 4196 | CD | ARG | B | 167 | 6157 | 4774 | 5969 | 1402 | −695 | −282 | C |
| ATOM | 4197 | NE | ARG | B | 167 | −13.125 | 70.875 | 17.671 | 1.00 | 37.99 | | N |
| ANISOU | 4197 | NE | ARG | B | 167 | 5158 | 4110 | 5166 | 1638 | −830 | −269 | N |
| ATOM | 4198 | CZ | ARG | B | 167 | −13.818 | 70.213 | 16.739 | 1.00 | 37.51 | | C |
| ANISOU | 4198 | CZ | ARG | B | 167 | 5037 | 4176 | 5039 | 1712 | −994 | −149 | C |
| ATOM | 4199 | NH1 | ARG | B | 167 | −13.210 | 69.658 | 15.698 | 1.00 | 34.51 | | N |
| ANISOU | 4199 | NH1 | ARG | B | 167 | 4803 | 3761 | 4547 | 1590 | −1033 | −38 | N |
| ATOM | 4200 | NH2 | ARG | B | 167 | −15.133 | 70.112 | 16.840 | 1.00 | 37.15 | | N |
| ANISOU | 4200 | NH2 | ARG | B | 167 | 4773 | 4305 | 5035 | 1907 | −1119 | −154 | N |
| ATOM | 4201 | N | LYS | B | 168 | −9.905 | 66.823 | 19.755 | 1.00 | 37.19 | | N |
| ANISOU | 4201 | N | LYS | B | 168 | 4600 | 4612 | 4919 | 765 | −599 | −374 | N |
| ATOM | 4202 | CA | LYS | B | 168 | −8.679 | 66.113 | 19.376 | 1.00 | 29.97 | | C |
| ANISOU | 4202 | CA | LYS | B | 168 | 3735 | 3686 | 3965 | 597 | −546 | −317 | C |
| ATOM | 4203 | C | LYS | B | 168 | −8.624 | 65.726 | 17.906 | 1.00 | 29.45 | | C |
| ANISOU | 4203 | C | LYS | B | 168 | 3824 | 3520 | 3845 | 608 | −595 | −199 | C |
| ATOM | 4204 | O | LYS | B | 168 | −9.652 | 65.448 | 17.284 | 1.00 | 29.68 | | O |
| ANISOU | 4204 | O | LYS | B | 168 | 3850 | 3579 | 3850 | 712 | −717 | −155 | O |
| ATOM | 4205 | CB | LYS | B | 168 | −8.488 | 64.837 | 20.210 | 1.00 | 37.32 | | C |
| ANISOU | 4205 | CB | LYS | B | 168 | 4465 | 4840 | 4877 | 503 | −535 | −312 | C |
| ATOM | 4206 | CG | LYS | B | 168 | −7.031 | 64.381 | 20.175 | 1.00 | 38.37 | | C |
| ANISOU | 4206 | CG | LYS | B | 168 | 4620 | 4969 | 4991 | 361 | −454 | −286 | C |
| ATOM | 4207 | CD | LYS | B | 168 | −6.816 | 62.965 | 20.579 | 1.00 | 39.28 | | C |
| ANISOU | 4207 | CD | LYS | B | 168 | 4597 | 5242 | 5085 | 308 | −455 | −225 | C |
| ATOM | 4208 | CE | LYS | B | 168 | −5.345 | 62.632 | 20.439 | 1.00 | 37.90 | | C |
| ANISOU | 4208 | CE | LYS | B | 168 | 4436 | 5060 | 4906 | 213 | −373 | −195 | C |
| ATOM | 4209 | NZ | LYS | B | 168 | −4.787 | 63.168 | 19.162 | 1.00 | 30.70 | | N |
| ANISOU | 4209 | NZ | LYS | B | 168 | 3710 | 3962 | 3992 | 197 | −323 | −167 | N |
| ATOM | 4210 | N | LEU | B | 169 | −7.409 | 65.693 | 17.364 | 1.00 | 30.29 | | N |
| ANISOU | 4210 | N | LEU | B | 169 | 4054 | 3533 | 3922 | 498 | −499 | −158 | N |
| ATOM | 4211 | CA | LEU | B | 169 | −7.172 | 65.208 | 16.012 | 1.00 | 28.62 | | C |
| ANISOU | 4211 | CA | LEU | B | 169 | 4001 | 3252 | 3620 | 499 | −509 | −58 | C |
| ATOM | 4212 | C | LEU | B | 169 | −7.100 | 63.671 | 16.016 | 1.00 | 27.84 | | C |
| ANISOU | 4212 | C | LEU | B | 169 | 3788 | 3296 | 3493 | 443 | −536 | −49 | C |
| ATOM | 4213 | O | LEU | B | 169 | −6.267 | 63.080 | 16.694 | 1.00 | 25.42 | | O |
| ANISOU | 4213 | O | LEU | B | 169 | 3365 | 3070 | 3221 | 351 | −453 | −66 | O |
| ATOM | 4214 | CB | LEU | B | 169 | −5.903 | 65.823 | 15.444 | 1.00 | 28.78 | | C |
| ANISOU | 4214 | CB | LEU | B | 169 | 4186 | 3124 | 3626 | 407 | −355 | −13 | C |
| ATOM | 4215 | CG | LEU | B | 169 | −5.699 | 65.682 | 13.935 | 1.00 | 37.13 | | C |
| ANISOU | 4215 | CG | LEU | B | 169 | 5473 | 4084 | 4551 | 440 | −332 | 98 | C |
| ATOM | 4216 | CD1 | LEU | B | 169 | −6.852 | 66.322 | 13.156 | 1.00 | 30.69 | | C |
| ANISOU | 4216 | CD1 | LEU | B | 169 | 4822 | 3178 | 3660 | 609 | −470 | 161 | C |
| ATOM | 4217 | CD2 | LEU | B | 169 | −4.390 | 66.338 | 13.539 | 1.00 | 45.68 | | C |
| ANISOU | 4217 | CD2 | LEU | B | 169 | 6677 | 5038 | 5641 | 323 | −134 | 151 | C |
| ATOM | 4218 | N | MET | B | 170 | −8.027 | 63.039 | 15.305 | 1.00 | 24.42 | | N |
| ANISOU | 4218 | N | MET | B | 170 | 3384 | 2892 | 3004 | 505 | −669 | −26 | N |
| ATOM | 4219 | CA | MET | B | 170 | −8.161 | 61.594 | 15.330 | 1.00 | 32.37 | | C |
| ANISOU | 4219 | CA | MET | B | 170 | 4301 | 3988 | 4008 | 445 | −708 | −34 | C |
| ATOM | 4220 | C | MET | B | 170 | −8.100 | 61.010 | 13.935 | 1.00 | 32.42 | | C |
| ANISOU | 4220 | C | MET | B | 170 | 4504 | 3923 | 3890 | 456 | −753 | −14 | C |
| ATOM | 4221 | O | MET | B | 170 | −8.351 | 61.702 | 12.955 | 1.00 | 33.82 | | O |
| ANISOU | 4221 | O | MET | B | 170 | 4860 | 4028 | 3962 | 534 | −807 | 19 | O |
| ATOM | 4222 | CB | MET | B | 170 | −9.473 | 61.199 | 16.010 | 1.00 | 34.66 | | C |
| ANISOU | 4222 | CB | MET | B | 170 | 4390 | 4409 | 4371 | 463 | −834 | −63 | C |
| ATOM | 4223 | CG | MET | B | 170 | −9.520 | 61.578 | 17.467 | 1.00 | 36.92 | | C |
| ANISOU | 4223 | CG | MET | B | 170 | 4486 | 4799 | 4743 | 456 | −767 | −94 | C |
| ATOM | 4224 | SD | MET | B | 170 | −11.156 | 61.431 | 18.191 | 1.00 | 34.99 | | S |
| ANISOU | 4224 | SD | MET | B | 170 | 4000 | 4721 | 4574 | 505 | −873 | −117 | S |
| ATOM | 4225 | CE | MET | B | 170 | −11.954 | 62.869 | 17.493 | 1.00 | 30.19 | | C |
| ANISOU | 4225 | CE | MET | B | 170 | 3481 | 4037 | 3951 | 690 | −972 | −135 | C |
| ATOM | 4226 | N | GLY | B | 171 | −7.768 | 59.730 | 13.843 | 1.00 | 28.88 | | N |
| ANISOU | 4226 | N | GLY | B | 171 | 4043 | 3488 | 3441 | 389 | −729 | −33 | N |
| ATOM | 4227 | CA | GLY | B | 171 | −7.697 | 59.084 | 12.552 | 1.00 | 27.11 | | C |
| ANISOU | 4227 | CA | GLY | B | 171 | 4023 | 3195 | 3081 | 399 | −764 | −52 | C |
| ATOM | 4228 | C | GLY | B | 171 | −8.948 | 58.272 | 12.277 | 1.00 | 31.61 | | C |
| ANISOU | 4228 | C | GLY | B | 171 | 4551 | 3809 | 3652 | 373 | −968 | −114 | C |
| ATOM | 4229 | O | GLY | B | 171 | −9.420 | 57.515 | 13.128 | 1.00 | 34.00 | | O |
| ANISOU | 4229 | O | GLY | B | 171 | 4666 | 4166 | 4088 | 297 | −1001 | −133 | O |
| ATOM | 4230 | N | CYS | B | 172 | −9.507 | 58.437 | 11.088 | 1.00 | 31.78 | | N |
| ANISOU | 4230 | N | CYS | B | 172 | 4742 | 3815 | 3519 | 425 | −1111 | −139 | N |
| ATOM | 4231 | CA | CYS | B | 172 | −10.512 | 57.499 | 10.621 | 1.00 | 33.27 | | C |
| ANISOU | 4231 | CA | CYS | B | 172 | 4913 | 4040 | 3687 | 365 | −1313 | −230 | C |
| ATOM | 4232 | C | CYS | B | 172 | −9.854 | 56.340 | 9.905 | 1.00 | 33.38 | | C |
| ANISOU | 4232 | C | CYS | B | 172 | 5122 | 3949 | 3612 | 306 | −1252 | −313 | C |
| ATOM | 4233 | O | CYS | B | 172 | −9.145 | 56.561 | 8.934 | 1.00 | 39.58 | | O |
| ANISOU | 4233 | O | CYS | B | 172 | 6153 | 4677 | 4208 | 375 | −1174 | −313 | O |
| ATOM | 4234 | CB | CYS | B | 172 | −11.502 | 58.188 | 9.688 | 1.00 | 42.70 | | C |
| ANISOU | 4234 | CB | CYS | B | 172 | 6181 | 5304 | 4738 | 460 | −1541 | −233 | C |
| ATOM | 4235 | SG | CYS | B | 172 | −12.776 | 59.087 | 10.565 | 1.00 | 91.63 | | S |
| ANISOU | 4235 | SG | CYS | B | 172 | 12074 | 11645 | 11094 | 532 | −1679 | −186 | S |
| ATOM | 4236 | N | HIS | B | 173 | −10.075 | 55.112 | 10.376 | 1.00 | 30.24 | | N |
| ANISOU | 4236 | N | HIS | B | 173 | 4629 | 3512 | 3348 | 184 | −1266 | −378 | N |
| ATOM | 4237 | CA | HIS | B | 173 | −9.631 | 53.934 | 9.623 | 1.00 | 33.20 | | C |
| ANISOU | 4237 | CA | HIS | B | 173 | 5216 | 3753 | 3648 | 138 | −1234 | −490 | C |
| ATOM | 4238 | C | HIS | B | 173 | −10.501 | 53.749 | 8.380 | 1.00 | 41.35 | | C |
| ANISOU | 4238 | C | HIS | B | 173 | 6410 | 4805 | 4495 | 115 | −1476 | −623 | C |
| ATOM | 4239 | O | HIS | B | 173 | −11.735 | 53.704 | 8.479 | 1.00 | 32.75 | | O |
| ANISOU | 4239 | O | HIS | B | 173 | 5159 | 3812 | 3471 | 33 | −1706 | −664 | O |
| ATOM | 4240 | CB | HIS | B | 173 | −9.688 | 52.643 | 10.463 | 1.00 | 40.87 | | C |
| ANISOU | 4240 | CB | HIS | B | 173 | 6071 | 4628 | 4831 | 11 | −1188 | −515 | C |
| ATOM | 4241 | CG | HIS | B | 173 | −8.908 | 52.698 | 11.738 | 1.00 | 39.50 | | C |
| ANISOU | 4241 | CG | HIS | B | 173 | 5730 | 4465 | 4815 | 39 | −988 | −381 | C |
| ATOM | 4242 | ND1 | HIS | B | 173 | −8.892 | 51.653 | 12.637 | 1.00 | 35.25 | | N |
| ANISOU | 4242 | ND1 | HIS | B | 173 | 5086 | 3850 | 4458 | −44 | −925 | −344 | N |
| ATOM | 4243 | CD2 | HIS | B | 173 | −8.139 | 53.675 | 12.283 | 1.00 | 37.49 | | C |
| ANISOU | 4243 | CD2 | HIS | B | 173 | 5395 | 4293 | 4556 | 133 | −851 | −273 | C |
| ATOM | 4244 | CE1 | HIS | B | 173 | −8.143 | 51.980 | 13.675 | 1.00 | 35.65 | | C |
| ANISOU | 4244 | CE1 | HIS | B | 173 | 4998 | 3966 | 4582 | 19 | −772 | −216 | C |
| ATOM | 4245 | NE2 | HIS | B | 173 | −7.677 | 53.205 | 13.486 | 1.00 | 32.60 | | N |
| ANISOU | 4245 | NE2 | HIS | B | 173 | 4616 | 3680 | 4092 | 114 | −732 | −188 | N |
| ATOM | 4246 | N | MET | B | 174 | −9.860 | 53.661 | 7.215 | 1.00 | 40.37 | | N |
| ANISOU | 4246 | N | MET | B | 174 | 6590 | 4618 | 4129 | 190 | −1425 | −691 | N |
| ATOM | 4247 | CA | MET | B | 174 | −10.555 | 53.293 | 5.985 | 1.00 | 35.99 | | C |
| ANISOU | 4247 | CA | MET | B | 174 | 6237 | 4084 | 3353 | 164 | −1655 | −850 | C |
| ATOM | 4248 | C | MET | B | 174 | −10.042 | 51.932 | 5.487 | 1.00 | 46.03 | | C |
| ANISOU | 4248 | C | MET | B | 174 | 7730 | 5176 | 4582 | 99 | −1575 | −1031 | C |
| ATOM | 4249 | O | MET | B | 174 | −10.672 | 51.284 | 4.653 | 1.00 | 44.19 | | O |
| ANISOU | 4249 | O | MET | B | 174 | 7649 | 4924 | 4217 | 18 | −1778 | −1222 | O |
| ATOM | 4250 | CB | MET | B | 174 | −10.394 | 54.374 | 4.910 | 1.00 | 37.08 | | C |
| ANISOU | 4250 | CB | MET | B | 174 | 6595 | 4315 | 3177 | 324 | −1687 | −789 | C |
| ATOM | 4251 | CG | MET | B | 174 | −11.095 | 55.686 | 5.236 | 1.00 | 39.57 | | C |
| ANISOU | 4251 | CG | MET | B | 174 | 6735 | 4772 | 3526 | 408 | −1813 | −632 | C |
| ATOM | 4252 | SD | MET | B | 174 | −12.790 | 55.527 | 5.859 | 1.00 | 59.49 | | S |
| ANISOU | 4252 | SD | MET | B | 174 | 8904 | 7442 | 6257 | 301 | −2143 | −682 | S |
| ATOM | 4253 | CE | MET | B | 174 | −13.721 | 55.590 | 4.343 | 1.00 | 41.04 | | C |
| ANISOU | 4253 | CE | MET | B | 174 | 6755 | 5245 | 3592 | 351 | −2502 | −793 | C |
| ATOM | 4254 | N | HIS | B | 175 | −8.909 | 51.498 | 6.031 | 1.00 | 47.40 | | N |
| ANISOU | 4254 | N | HIS | B | 175 | 7916 | 5219 | 4877 | 140 | −1289 | −981 | N |
| ATOM | 4255 | CA | HIS | B | 175 | −8.346 | 50.177 | 5.736 | 1.00 | 44.86 | | C |
| ANISOU | 4255 | CA | HIS | B | 175 | 7787 | 4688 | 4568 | 116 | −1172 | −1136 | C |
| ATOM | 4256 | C | HIS | B | 175 | −7.773 | 49.576 | 7.015 | 1.00 | 46.55 | | C |
| ANISOU | 4256 | C | HIS | B | 175 | 7811 | 4787 | 5090 | 97 | −981 | −1029 | C |
| ATOM | 4257 | O | HIS | B | 175 | −6.921 | 50.186 | 7.663 | 1.00 | 49.20 | | O |
| ANISOU | 4257 | O | HIS | B | 175 | 8016 | 5187 | 5491 | 201 | −787 | −861 | O |
| ATOM | 4258 | CB | HIS | B | 175 | −7.258 | 50.256 | 4.655 | 1.00 | 47.33 | | C |
| ANISOU | 4258 | CB | HIS | B | 175 | 8413 | 4968 | 4602 | 281 | −973 | −1192 | C |
| ATOM | 4259 | CG | HIS | B | 175 | −6.528 | 48.963 | 4.430 | 1.00 | 62.66 | | C |
| ANISOU | 4259 | CG | HIS | B | 175 | 10547 | 6685 | 6575 | 312 | −798 | −1344 | C |
| ATOM | 4260 | ND1 | HIS | B | 175 | −7.015 | 47.961 | 3.616 | 1.00 | 64.07 | | N |
| ANISOU | 4260 | ND1 | HIS | B | 175 | 10980 | 6723 | 6643 | 235 | −934 | −1605 | N |
| ATOM | 4261 | CD2 | HIS | B | 175 | −5.345 | 48.510 | 4.914 | 1.00 | 62.81 | | C |
| ANISOU | 4261 | CD2 | HIS | B | 175 | 10543 | 6591 | 6731 | 428 | −503 | −1280 | C |
| ATOM | 4262 | CE1 | HIS | B | 175 | −6.163 | 46.950 | 3.606 | 1.00 | 61.85 | | C |
| ANISOU | 4262 | CE1 | HIS | B | 175 | 10848 | 6220 | 6433 | 313 | −711 | −1698 | C |
| ATOM | 4263 | NE2 | HIS | B | 175 | −5.144 | 47.255 | 4.390 | 1.00 | 56.81 | | N |
| ANISOU | 4263 | NE2 | HIS | B | 175 | 10032 | 5604 | 5948 | 443 | −449 | −1491 | N |
| ATOM | 4264 | N | GLU | B | 176 | −8.266 | 48.395 | 7.382 | 1.00 | 45.97 | | N |
| ANISOU | 4264 | N | GLU | B | 176 | 9050 | 4731 | 3684 | 516 | −1110 | −136 | N |
| ATOM | 4265 | CA | GLU | B | 176 | −7.771 | 47.631 | 8.536 | 1.00 | 41.33 | | C |
| ANISOU | 4265 | CA | GLU | B | 176 | 8207 | 4276 | 3221 | 440 | −999 | −158 | C |
| ATOM | 4266 | C | GLU | B | 176 | −7.227 | 46.267 | 8.079 | 1.00 | 40.33 | | C |
| ANISOU | 4266 | C | GLU | B | 176 | 8289 | 4060 | 2975 | 503 | −965 | −191 | C |
| ATOM | 4267 | O | GLU | B | 176 | −7.397 | 45.887 | 6.925 | 1.00 | 40.32 | | O |
| ANISOU | 4267 | O | GLU | B | 176 | 8555 | 3891 | 2873 | 589 | −1044 | −196 | O |
| ATOM | 4268 | CB | GLU | B | 176 | −8.880 | 47.443 | 9.567 | 1.00 | 39.32 | | C |
| ANISOU | 4268 | CB | GLU | B | 176 | 7609 | 4105 | 3226 | 297 | −1226 | −177 | C |
| ATOM | 4269 | CG | GLU | B | 176 | −9.158 | 48.663 | 10.390 | 1.00 | 37.98 | | C |
| ANISOU | 4269 | CG | GLU | B | 176 | 7113 | 4062 | 3257 | 228 | −1155 | −144 | C |
| ATOM | 4270 | CD | GLU | B | 176 | −10.300 | 48.468 | 11.369 | 1.00 | 41.32 | | C |
| ANISOU | 4270 | CD | GLU | B | 176 | 7217 | 4553 | 3929 | 107 | −1353 | −151 | C |
| ATOM | 4271 | OE1 | GLU | B | 176 | −11.061 | 47.492 | 11.214 | 1.00 | 47.99 | | O |
| ANISOU | 4271 | OE1 | GLU | B | 176 | 8111 | 5319 | 4803 | 72 | −1598 | −171 | O |
| ATOM | 4272 | OE2 | GLU | B | 176 | −10.410 | 49.272 | 12.323 | 1.00 | 35.17 | | O |
| ANISOU | 4272 | OE2 | GLU | B | 176 | 6138 | 3900 | 3326 | 52 | −1252 | −132 | O |
| ATOM | 4273 | N | GLU | B | 177 | −6.587 | 45.525 | 8.977 | 1.00 | 44.83 | | N |
| ANISOU | 4273 | N | GLU | B | 177 | 8699 | 4730 | 3606 | 461 | −839 | −209 | N |
| ATOM | 4274 | CA | GLU | B | 177 | −5.731 | 44.408 | 8.561 | 1.00 | 41.81 | | C |
| ANISOU | 4274 | CA | GLU | B | 177 | 8487 | 4274 | 3124 | 543 | −706 | −224 | C |
| ATOM | 4275 | C | GLU | B | 177 | −5.477 | 43.387 | 9.664 | 1.00 | 37.31 | | C |
| ANISOU | 4275 | C | GLU | B | 177 | 7717 | 3800 | 2657 | 463 | −700 | −260 | C |
| ATOM | 4276 | O | GLU | B | 177 | −5.302 | 43.763 | 10.824 | 1.00 | 34.02 | | O |
| ANISOU | 4276 | O | GLU | B | 177 | 6935 | 3539 | 2454 | 369 | −596 | −240 | O |
| ATOM | 4277 | CB | GLU | B | 177 | −4.394 | 44.973 | 8.121 | 1.00 | 45.08 | | C |
| ANISOU | 4277 | CB | GLU | B | 177 | 9003 | 4684 | 3441 | 658 | −337 | −171 | C |
| ATOM | 4278 | CG | GLU | B | 177 | −3.870 | 44.553 | 6.807 | 1.00 | 48.37 | | C |
| ANISOU | 4278 | CG | GLU | B | 177 | 9735 | 4930 | 3716 | 805 | −237 | −151 | C |
| ATOM | 4279 | CD | GLU | B | 177 | −2.632 | 45.346 | 6.490 | 1.00 | 51.54 | | C |
| ANISOU | 4279 | CD | GLU | B | 177 | 10163 | 5336 | 4085 | 902 | 137 | −75 | C |
| ATOM | 4280 | OE1 | GLU | B | 177 | −2.595 | 45.995 | 5.417 | 1.00 | 56.22 | | O |
| ANISOU | 4280 | OE1 | GLU | B | 177 | 10974 | 5812 | 4576 | 1000 | 194 | −34 | O |
| ATOM | 4281 | OE2 | GLU | B | 177 | −1.710 | 45.336 | 7.346 | 1.00 | 41.34 | | O |
| ANISOU | 4281 | OE2 | GLU | B | 177 | 8658 | 4157 | 2890 | 876 | 369 | −53 | O |
| ATOM | 4282 | N | SER | B | 178 | −5.384 | 42.112 | 9.293 | 1.00 | 38.29 | | N |
| ANISOU | 4282 | N | SER | B | 178 | 7982 | 3826 | 2739 | 498 | −766 | −288 | N |
| ATOM | 4283 | CA | SER | B | 178 | −4.915 | 41.067 | 10.207 | 1.00 | 38.43 | | C |
| ANISOU | 4283 | CA | SER | B | 178 | 7865 | 3916 | 2822 | 449 | −717 | −318 | C |
| ATOM | 4284 | C | SER | B | 178 | −5.683 | 41.043 | 11.525 | 1.00 | 29.76 | | C |
| ANISOU | 4284 | C | SER | B | 178 | 6381 | 2952 | 1976 | 287 | −858 | −317 | C |
| ATOM | 4285 | O | SER | B | 178 | −6.891 | 40.866 | 11.529 | 1.00 | 36.78 | | O |
| ANISOU | 4285 | O | SER | B | 178 | 7240 | 3797 | 2937 | 213 | −1146 | −329 | O |
| ATOM | 4286 | CB | SER | B | 178 | −3.421 | 41.234 | 10.485 | 1.00 | 44.24 | | C |
| ANISOU | 4286 | CB | SER | B | 178 | 8540 | 4721 | 3548 | 518 | −343 | −287 | C |
| ATOM | 4287 | OG | SER | B | 178 | −2.713 | 41.441 | 9.274 | 1.00 | 58.62 | | O |
| ANISOU | 4287 | OG | SER | B | 178 | 10639 | 6422 | 5214 | 668 | −160 | −252 | O |
| ATOM | 4288 | N | LEU | B | 179 | −4.983 | 41.241 | 12.636 | 1.00 | 28.11 | | N |
| ANISOU | 4288 | N | LEU | B | 179 | 5866 | 2892 | 1921 | 237 | −648 | −293 | N |
| ATOM | 4289 | CA | LEU | B | 179 | −5.615 | 41.204 | 13.957 | 1.00 | 26.66 | | C |
| ANISOU | 4289 | CA | LEU | B | 179 | 5326 | 2835 | 1967 | 102 | −734 | −283 | C |
| ATOM | 4290 | C | LEU | B | 179 | −6.771 | 42.194 | 14.127 | 1.00 | 31.18 | | C |
| ANISOU | 4290 | C | LEU | B | 179 | 5756 | 3443 | 2649 | 34 | −886 | −263 | C |
| ATOM | 4291 | O | LEU | B | 179 | −7.704 | 41.931 | 14.867 | 1.00 | 34.27 | | O |
| ANISOU | 4291 | O | LEU | B | 179 | 5942 | 3875 | 3202 | −64 | −1041 | −253 | O |
| ATOM | 4292 | CB | LEU | B | 179 | −4.580 | 41.456 | 15.047 | 1.00 | 25.16 | | C |
| ANISOU | 4292 | CB | LEU | B | 179 | 4880 | 2786 | 1894 | 83 | −484 | −264 | C |
| ATOM | 4293 | CG | LEU | B | 179 | −3.534 | 40.350 | 15.226 | 1.00 | 39.72 | | C |
| ANISOU | 4293 | CG | LEU | B | 179 | 6770 | 4615 | 3707 | 124 | −355 | −278 | C |
| ATOM | 4294 | CD1 | LEU | B | 179 | −2.511 | 40.779 | 16.270 | 1.00 | 26.83 | | C |
| ANISOU | 4294 | CD1 | LEU | B | 179 | 4881 | 3106 | 2209 | 107 | −136 | −255 | C |
| ATOM | 4295 | CD2 | LEU | B | 179 | −4.154 | 38.982 | 15.563 | 1.00 | 25.40 | | C |
| ANISOU | 4295 | CD2 | LEU | B | 179 | 4957 | 2765 | 1927 | 64 | −551 | −301 | C |
| ATOM | 4296 | N | PHE | B | 180 | −6.712 | 43.333 | 13.450 | 1.00 | 34.22 | | N |
| ANISOU | 4296 | N | PHE | B | 180 | 6241 | 3805 | 2956 | 90 | −830 | −247 | N |
| ATOM | 4297 | CA | PHE | B | 180 | −7.791 | 44.303 | 13.552 | 1.00 | 32.31 | | C |
| ANISOU | 4297 | CA | PHE | B | 180 | 5873 | 3585 | 2819 | 37 | −974 | −228 | C |
| ATOM | 4298 | C | PHE | B | 180 | −9.093 | 43.737 | 12.968 | 1.00 | 37.93 | | C |
| ANISOU | 4298 | C | PHE | B | 180 | 6702 | 4170 | 3539 | 5 | −1313 | −240 | C |
| ATOM | 4299 | O | PHE | B | 180 | −10.179 | 44.166 | 13.342 | 1.00 | 39.96 | | O |
| ANISOU | 4299 | O | PHE | B | 180 | 6772 | 4447 | 3963 | −68 | −1472 | −217 | O |
| ATOM | 4300 | CB | PHE | B | 180 | −7.392 | 45.618 | 12.867 | 1.00 | 30.65 | | C |
| ANISOU | 4300 | CB | PHE | B | 180 | 5773 | 3358 | 2514 | 111 | −844 | −205 | C |
| ATOM | 4301 | CG | PHE | B | 180 | −6.494 | 46.484 | 13.709 | 1.00 | 34.77 | | C |
| ANISOU | 4301 | CG | PHE | B | 180 | 6064 | 4011 | 3135 | 101 | −579 | −182 | C |
| ATOM | 4302 | CD2 | PHE | B | 180 | −7.018 | 47.536 | 14.451 | 1.00 | 33.12 | | C |
| ANISOU | 4302 | CD2 | PHE | B | 180 | 5608 | 3895 | 3083 | 41 | −589 | −166 | C |
| ATOM | 4303 | CD1 | PHE | B | 180 | −5.129 | 46.241 | 13.776 | 1.00 | 34.31 | | C |
| ANISOU | 4303 | CD1 | PHE | B | 180 | 6033 | 3970 | 3032 | 155 | −332 | −175 | C |
| ATOM | 4304 | CE2 | PHE | B | 180 | −6.198 | 48.329 | 15.240 | 1.00 | 28.82 | | C |
| ANISOU | 4304 | CE2 | PHE | B | 180 | 4867 | 3450 | 2632 | 33 | −379 | −154 | C |
| ATOM | 4305 | CE1 | PHE | B | 180 | −4.306 | 47.030 | 14.564 | 1.00 | 30.07 | | C |
| ANISOU | 4305 | CE1 | PHE | B | 180 | 5275 | 3533 | 2618 | 139 | −127 | −154 | C |
| ATOM | 4306 | CZ | PHE | B | 180 | −4.845 | 48.078 | 15.299 | 1.00 | 30.19 | | C |
| ANISOU | 4306 | CZ | PHE | B | 180 | 5064 | 3632 | 2773 | 77 | −162 | −148 | C |
| ATOM | 4307 | N | LEU | B | 181 | −8.978 | 42.747 | 12.083 | 1.00 | 43.79 | | N |
| ANISOU | 4307 | N | LEU | B | 181 | 7748 | 4771 | 4119 | 62 | −1429 | −274 | N |
| ATOM | 4308 | CA | LEU | B | 181 | −10.148 | 42.075 | 11.507 | 1.00 | 45.65 | | C |
| ANISOU | 4308 | CA | LEU | B | 181 | 8115 | 4857 | 4374 | 31 | −1789 | −292 | C |
| ATOM | 4309 | C | LEU | B | 181 | −10.773 | 41.039 | 12.445 | 1.00 | 42.63 | | C |
| ANISOU | 4309 | C | LEU | B | 181 | 7487 | 4501 | 4209 | −85 | −1924 | −283 | C |
| ATOM | 4310 | O | LEU | B | 181 | −11.770 | 40.404 | 12.099 | 1.00 | 42.21 | | O |
| ANISOU | 4310 | O | LEU | B | 181 | 7438 | 4322 | 4277 | −121 | −2170 | −271 | O |
| ATOM | 4311 | CB | LEU | B | 181 | −9.775 | 41.378 | 10.192 | 1.00 | 45.87 | | C |
| ANISOU | 4311 | CB | LEU | B | 181 | 8501 | 4706 | 4222 | 152 | −1795 | −313 | C |
| ATOM | 4312 | CG | LEU | B | 181 | −9.292 | 42.248 | 9.028 | 1.00 | 49.38 | | C |
| ANISOU | 4312 | CG | LEU | B | 181 | 9223 | 5071 | 4468 | 282 | −1673 | −304 | C |
| ATOM | 4313 | CD1 | LEU | B | 181 | −9.090 | 41.379 | 7.777 | 1.00 | 42.80 | | C |
| ANISOU | 4313 | CD1 | LEU | B | 181 | 8735 | 4036 | 3489 | 398 | −1717 | −322 | C |
| ATOM | 4314 | CD2 | LEU | B | 181 | −10.247 | 43.403 | 8.764 | 1.00 | 34.41 | | C |
| ANISOU | 4314 | CD2 | LEU | B | 181 | 7274 | 3157 | 2643 | 256 | −1825 | −278 | C |
| ATOM | 4315 | N | TYR | B | 182 | −10.184 | 40.865 | 13.624 | 1.00 | 31.91 | | N |
| ANISOU | 4315 | N | TYR | B | 182 | 5867 | 3300 | 2959 | −132 | −1700 | −265 | N |
| ATOM | 4316 | CA | TYR | B | 182 | −10.681 | 39.896 | 14.591 | 1.00 | 32.62 | | C |
| ANISOU | 4316 | CA | TYR | B | 182 | 5727 | 3422 | 3244 | −234 | −1781 | −243 | C |
| ATOM | 4317 | C | TYR | B | 182 | −10.615 | 40.491 | 15.974 | 1.00 | 37.41 | | C |
| ANISOU | 4317 | C | TYR | B | 182 | 5975 | 4216 | 4022 | −296 | −1582 | −199 | C |
| ATOM | 4318 | O | TYR | B | 182 | −10.065 | 39.894 | 16.886 | 1.00 | 45.50 | | O |
| ANISOU | 4318 | O | TYR | B | 182 | 6869 | 5327 | 5092 | −323 | −1443 | −192 | O |
| ATOM | 4319 | CB | TYR | B | 182 | −9.871 | 38.599 | 14.531 | 1.00 | 34.95 | | C |
| ANISOU | 4319 | CB | TYR | B | 182 | 6174 | 3671 | 3433 | −203 | −1735 | −279 | C |
| ATOM | 4320 | CG | TYR | B | 182 | −9.873 | 37.950 | 13.170 | 1.00 | 37.34 | | C |
| ANISOU | 4320 | CG | TYR | B | 182 | 6870 | 3775 | 3540 | −121 | −1917 | −330 | C |
| ATOM | 4321 | CD1 | TYR | B | 182 | −8.920 | 38.294 | 12.217 | 1.00 | 42.28 | | C |
| ANISOU | 4321 | CD1 | TYR | B | 182 | 7781 | 4355 | 3928 | 16 | −1745 | −357 | C |
| ATOM | 4322 | CD2 | TYR | B | 182 | −10.822 | 36.993 | 12.834 | 1.00 | 36.66 | | C |
| ANISOU | 4322 | CD2 | TYR | B | 182 | 6798 | 3544 | 3586 | −159 | −2162 | −314 | C |
| ATOM | 4323 | CE1 | TYR | B | 182 | −8.909 | 37.708 | 10.962 | 1.00 | 43.25 | | C |
| ANISOU | 4323 | CE1 | TYR | B | 182 | 8208 | 4294 | 3931 | 118 | −1819 | −372 | C |
| ATOM | 4324 | CE2 | TYR | B | 182 | −10.818 | 36.397 | 11.580 | 1.00 | 40.67 | | C |
| ANISOU | 4324 | CE2 | TYR | B | 182 | 7619 | 3863 | 3971 | −61 | −2260 | −337 | C |
| ATOM | 4325 | CZ | TYR | B | 182 | −9.860 | 36.761 | 10.648 | 1.00 | 44.66 | | C |
| ANISOU | 4325 | CZ | TYR | B | 182 | 8418 | 4327 | 4223 | 80 | −2089 | −368 | C |
| ATOM | 4326 | OH | TYR | B | 182 | −9.847 | 36.180 | 9.401 | 1.00 | 56.34 | | O |
| ANISOU | 4326 | OH | TYR | B | 182 | 10224 | 5608 | 5573 | 188 | −2180 | −385 | O |
| ATOM | 4327 | N | GLN | B | 183 | −11.183 | 41.682 | 16.124 | 1.00 | 39.92 | | N |
| ANISOU | 4327 | N | GLN | B | 183 | 6155 | 4587 | 4427 | −310 | −1578 | −172 | N |
| ATOM | 4328 | CA | GLN | B | 183 | −11.022 | 42.442 | 17.345 | 1.00 | 32.18 | | C |
| ANISOU | 4328 | CA | GLN | B | 183 | 4890 | 3774 | 3564 | −340 | −1374 | −142 | C |
| ATOM | 4329 | C | GLN | B | 183 | −12.338 | 43.065 | 17.798 | 1.00 | 32.31 | | C |
| ANISOU | 4329 | C | GLN | B | 183 | 4675 | 3808 | 3794 | −401 | −1484 | −90 | C |
| ATOM | 4330 | O | GLN | B | 183 | −13.028 | 43.721 | 17.022 | 1.00 | 41.73 | | O |
| ANISOU | 4330 | O | GLN | B | 183 | 5934 | 4921 | 5000 | −386 | −1635 | −84 | O |
| ATOM | 4331 | CB | GLN | B | 183 | −9.928 | 43.492 | 17.122 | 1.00 | 26.97 | | C |
| ANISOU | 4331 | CB | GLN | B | 183 | 4309 | 3176 | 2764 | −263 | −1154 | −168 | C |
| ATOM | 4332 | CG | GLN | B | 183 | −10.005 | 44.757 | 17.916 | 1.00 | 25.45 | | C |
| ANISOU | 4332 | CG | GLN | B | 183 | 3898 | 3102 | 2669 | −274 | −1023 | −149 | C |
| ATOM | 4333 | CD | GLN | B | 183 | −9.067 | 45.816 | 17.346 | 1.00 | 30.76 | | C |
| ANISOU | 4333 | CD | GLN | B | 183 | 4692 | 3781 | 3214 | −199 | −867 | −167 | C |
| ATOM | 4334 | OE1 | GLN | B | 183 | −7.888 | 45.548 | 17.125 | 1.00 | 31.72 | | O |
| ANISOU | 4334 | OE1 | GLN | B | 183 | 4929 | 3900 | 3224 | −149 | −718 | −186 | O |
| ATOM | 4335 | NE2 | GLN | B | 183 | −9.599 | 47.010 | 17.067 | 1.00 | 26.82 | | N |
| ANISOU | 4335 | NE2 | GLN | B | 183 | 4166 | 3277 | 2747 | −187 | −900 | −153 | N |
| ATOM | 4336 | N | GLN | B | 184 | −12.695 | 42.831 | 19.057 | 1.00 | 35.39 | | N |
| ANISOU | 4336 | N | GLN | B | 184 | 4801 | 4293 | 4353 | −460 | −1405 | −45 | N |
| ATOM | 4337 | CA | GLN | B | 184 | −13.929 | 43.373 | 19.609 | 1.00 | 38.83 | | C |
| ANISOU | 4337 | CA | GLN | B | 184 | 4994 | 4748 | 5013 | −506 | −1462 | 19 | C |
| ATOM | 4338 | C | GLN | B | 184 | −13.858 | 44.898 | 19.766 | 1.00 | 37.28 | | C |
| ANISOU | 4338 | C | GLN | B | 184 | 4730 | 4631 | 4801 | −461 | −1336 | 10 | C |
| ATOM | 4339 | O | GLN | B | 184 | −14.791 | 45.608 | 19.382 | 1.00 | 36.51 | | O |
| ANISOU | 4339 | O | GLN | B | 184 | 4577 | 4482 | 4812 | −463 | −1458 | 38 | O |
| ATOM | 4340 | CB | GLN | B | 184 | −14.244 | 42.716 | 20.955 | 1.00 | 42.12 | | C |
| ANISOU | 4340 | CB | GLN | B | 184 | 5172 | 5243 | 5588 | −561 | −1362 | 79 | C |
| ATOM | 4341 | CG | GLN | B | 184 | −15.077 | 41.442 | 20.840 | 1.00 | 55.81 | | C |
| ANISOU | 4341 | CG | GLN | B | 184 | 6862 | 6862 | 7479 | −633 | −1559 | 133 | C |
| ATOM | 4342 | CD | GLN | B | 184 | −16.526 | 41.707 | 20.428 | 1.00 | 69.01 | | C |
| ANISOU | 4342 | CD | GLN | B | 184 | 8409 | 8425 | 9387 | −676 | −1778 | 198 | C |
| ATOM | 4343 | OE1 | GLN | B | 184 | −16.864 | 41.718 | 19.237 | 1.00 | 64.72 | | O |
| ANISOU | 4343 | OE1 | GLN | B | 184 | 8030 | 7743 | 8817 | −671 | −2021 | 170 | O |
| ATOM | 4344 | NE2 | GLN | B | 184 | −17.389 | 41.917 | 21.418 | 1.00 | 76.70 | | N |
| ANISOU | 4344 | NE2 | GLN | B | 184 | 9095 | 9449 | 10597 | −711 | −1692 | 289 | N |
| ATOM | 4345 | N | ALA | B | 185 | −12.755 | 45.407 | 20.314 | 1.00 | 36.13 | | N |
| ANISOU | 4345 | N | ALA | B | 185 | 4590 | 4597 | 4539 | −419 | −1110 | −27 | N |
| ATOM | 4346 | CA | ALA | B | 185 | −12.639 | 46.852 | 20.553 | 1.00 | 30.61 | | C |
| ANISOU | 4346 | CA | ALA | B | 185 | 3824 | 3967 | 3840 | −379 | −993 | −38 | C |
| ATOM | 4347 | C | ALA | B | 185 | −12.697 | 47.621 | 19.236 | 1.00 | 32.73 | | C |
| ANISOU | 4347 | C | ALA | B | 185 | 4273 | 4143 | 4020 | −337 | −1099 | −57 | C |
| ATOM | 4348 | O | ALA | B | 185 | −12.200 | 47.174 | 18.193 | 1.00 | 29.16 | | O |
| ANISOU | 4348 | O | ALA | B | 185 | 4059 | 3603 | 3417 | −308 | −1166 | −85 | O |
| ATOM | 4349 | CB | ALA | B | 185 | −11.361 | 47.180 | 21.307 | 1.00 | 24.04 | | C |
| ANISOU | 4349 | CB | ALA | B | 185 | 2981 | 3241 | 2911 | −346 | −769 | −77 | C |
| ATOM | 4350 | N | THR | B | 186 | −13.326 | 48.779 | 19.272 | 1.00 | 37.00 | | N |
| ANISOU | 4350 | N | THR | B | 186 | 4718 | 4695 | 4646 | −323 | −1110 | −40 | N |
| ATOM | 4351 | CA | THR | B | 186 | −13.551 | 49.502 | 18.040 | 1.00 | 38.63 | | C |
| ANISOU | 4351 | CA | THR | B | 186 | 5093 | 4802 | 4783 | −284 | −1235 | −46 | C |
| ATOM | 4352 | C | THR | B | 186 | −12.288 | 50.237 | 17.579 | 1.00 | 34.05 | | C |
| ANISOU | 4352 | C | THR | B | 186 | 4680 | 4240 | 4019 | −221 | −1073 | −84 | C |
| ATOM | 4353 | O | THR | B | 186 | −12.010 | 50.298 | 16.385 | 1.00 | 32.24 | | O |
| ANISOU | 4353 | O | THR | B | 186 | 4696 | 3911 | 3643 | −176 | −1140 | −94 | O |
| ATOM | 4354 | CB | THR | B | 186 | −14.721 | 50.445 | 18.203 | 1.00 | 41.10 | | C |
| ANISOU | 4354 | CB | THR | B | 186 | 5238 | 5106 | 5274 | −291 | −1319 | −8 | C |
| ATOM | 4355 | OG1 | THR | B | 186 | −15.889 | 49.654 | 18.426 | 1.00 | 36.16 | | O |
| ANISOU | 4355 | OG1 | THR | B | 186 | 4468 | 4429 | 4843 | −349 | −1484 | 44 | O |
| ATOM | 4356 | CG2 | THR | B | 186 | −14.926 | 51.275 | 16.953 | 1.00 | 41.53 | | C |
| ANISOU | 4356 | CG2 | THR | B | 186 | 5476 | 5055 | 5250 | −245 | −1453 | −12 | C |
| ATOM | 4357 | N | GLY | B | 187 | −11.506 | 50.771 | 18.510 | 1.00 | 34.84 | | N |
| ANISOU | 4357 | N | GLY | B | 187 | 4660 | 4451 | 4128 | −212 | −863 | −101 | N |
| ATOM | 4358 | CA | GLY | B | 187 | −10.296 | 51.475 | 18.117 | 1.00 | 32.00 | | C |
| ANISOU | 4358 | CA | GLY | B | 187 | 4420 | 4094 | 3645 | −160 | −708 | −122 | C |
| ATOM | 4359 | C | GLY | B | 187 | −9.139 | 51.413 | 19.086 | 1.00 | 29.58 | | C |
| ANISOU | 4359 | C | GLY | B | 187 | 4019 | 3880 | 3339 | −161 | −511 | −146 | C |
| ATOM | 4360 | O | GLY | B | 187 | −9.082 | 50.549 | 19.951 | 1.00 | 26.13 | | O |
| ANISOU | 4360 | O | GLY | B | 187 | 3484 | 3502 | 2943 | −195 | −490 | −154 | O |
| ATOM | 4361 | N | VAL | B | 188 | −8.205 | 52.351 | 18.936 | 1.00 | 31.12 | | N |
| ANISOU | 4361 | N | VAL | B | 188 | 4247 | 4077 | 3502 | −123 | −375 | −153 | N |
| ATOM | 4362 | CA | VAL | B | 188 | −7.017 | 52.371 | 19.769 | 1.00 | 23.43 | | C |
| ANISOU | 4362 | CA | VAL | B | 188 | 3187 | 3165 | 2552 | −123 | −215 | −174 | C |
| ATOM | 4363 | C | VAL | B | 188 | −6.803 | 53.738 | 20.424 | 1.00 | 26.79 | | C |
| ANISOU | 4363 | C | VAL | B | 188 | 3485 | 3628 | 3065 | −114 | −143 | −187 | C |
| ATOM | 4364 | O | VAL | B | 188 | −6.873 | 54.783 | 19.779 | 1.00 | 31.10 | | O |
| ANISOU | 4364 | O | VAL | B | 188 | 4082 | 4124 | 3610 | −87 | −137 | −171 | O |
| ATOM | 4365 | CB | VAL | B | 188 | −5.758 | 51.996 | 18.969 | 1.00 | 26.58 | | C |
| ANISOU | 4365 | CB | VAL | B | 188 | 3743 | 3503 | 2854 | −83 | −100 | −164 | C |
| ATOM | 4366 | CG1 | VAL | B | 188 | −4.512 | 52.097 | 19.854 | 1.00 | 19.67 | | C |
| ANISOU | 4366 | CG1 | VAL | B | 188 | 2746 | 2675 | 2052 | −86 | 45 | −178 | C |
| ATOM | 4367 | CG2 | VAL | B | 188 | −5.890 | 50.580 | 18.411 | 1.00 | 29.50 | | C |
| ANISOU | 4367 | CG2 | VAL | B | 188 | 4255 | 3829 | 3125 | −82 | −170 | −163 | C |
| ATOM | 4368 | N | LEU | B | 189 | −6.536 | 53.712 | 21.720 | 1.00 | 23.83 | | N |
| ANISOU | 4368 | N | LEU | B | 189 | 2963 | 3331 | 2761 | −132 | −96 | −217 | N |
| ATOM | 4369 | CA | LEU | B | 189 | −6.232 | 54.910 | 22.455 | 1.00 | 25.09 | | C |
| ANISOU | 4369 | CA | LEU | B | 189 | 3021 | 3514 | 2999 | −118 | −44 | −243 | C |
| ATOM | 4370 | C | LEU | B | 189 | −4.767 | 54.918 | 22.828 | 1.00 | 23.03 | | C |
| ANISOU | 4370 | C | LEU | B | 189 | 2739 | 3246 | 2765 | −114 | 55 | −259 | C |
| ATOM | 4371 | O | LEU | B | 189 | −4.371 | 54.347 | 23.841 | 1.00 | 26.86 | | O |
| ANISOU | 4371 | O | LEU | B | 189 | 3155 | 3780 | 3271 | −127 | 64 | −288 | O |
| ATOM | 4372 | CB | LEU | B | 189 | −7.103 | 55.008 | 23.704 | 1.00 | 24.86 | | C |
| ANISOU | 4372 | CB | LEU | B | 189 | 2861 | 3560 | 3026 | −124 | −79 | −267 | C |
| ATOM | 4373 | CG | LEU | B | 189 | −6.810 | 56.182 | 24.627 | 1.00 | 32.58 | | C |
| ANISOU | 4373 | CG | LEU | B | 189 | 3758 | 4555 | 4065 | −98 | −39 | −309 | C |
| ATOM | 4374 | CD1 | LEU | B | 189 | −6.855 | 57.518 | 23.877 | 1.00 | 39.44 | | C |
| ANISOU | 4374 | CD1 | LEU | B | 189 | 4654 | 5361 | 4969 | −76 | −42 | −300 | C |
| ATOM | 4375 | CD2 | LEU | B | 189 | −7.777 | 56.158 | 25.785 | 1.00 | 30.54 | | C |
| ANISOU | 4375 | CD2 | LEU | B | 189 | 3410 | 4362 | 3832 | −82 | −51 | −324 | C |
| ATOM | 4376 | N | GLY | B | 190 | −3.968 | 55.598 | 22.018 | 1.00 | 21.55 | | N |
| ANISOU | 4376 | N | GLY | B | 190 | 2609 | 2986 | 2595 | −94 | 128 | −233 | N |
| ATOM | 4377 | CA | GLY | B | 190 | −2.553 | 55.744 | 22.308 | 1.00 | 19.77 | | C |
| ANISOU | 4377 | CA | GLY | B | 190 | 2333 | 2730 | 2450 | −91 | 222 | −233 | C |
| ATOM | 4378 | C | GLY | B | 190 | −2.340 | 56.681 | 23.485 | 1.00 | 27.38 | | C |
| ANISOU | 4378 | C | GLY | B | 190 | 3167 | 3713 | 3525 | −98 | 191 | −281 | C |
| ATOM | 4379 | O | GLY | B | 190 | −2.925 | 57.767 | 23.543 | 1.00 | 27.01 | | O |
| ANISOU | 4379 | O | GLY | B | 190 | 3100 | 3657 | 3507 | −88 | 156 | −293 | O |
| ATOM | 4380 | N | MET | B | 191 | −1.474 | 56.280 | 24.409 | 1.00 | 24.04 | | N |
| ANISOU | 4380 | N | MET | B | 191 | 2669 | 3302 | 3163 | −108 | 192 | −311 | N |
| ATOM | 4381 | CA | MET | B | 191 | −1.289 | 57.024 | 25.643 | 1.00 | 26.40 | | C |
| ANISOU | 4381 | CA | MET | B | 191 | 2880 | 3610 | 3542 | −106 | 129 | −370 | C |
| ATOM | 4382 | C | MET | B | 191 | 0.084 | 57.670 | 25.796 | 1.00 | 28.87 | | C |
| ANISOU | 4382 | C | MET | B | 191 | 3119 | 3832 | 4018 | −112 | 147 | −367 | C |
| ATOM | 4383 | O | MET | B | 191 | 0.441 | 58.064 | 26.895 | 1.00 | 28.28 | | O |
| ANISOU | 4383 | O | MET | B | 191 | 2987 | 3747 | 4012 | −110 | 64 | −424 | O |
| ATOM | 4384 | CB | MET | B | 191 | −1.563 | 56.111 | 26.840 | 1.00 | 23.35 | | C |
| ANISOU | 4384 | CB | MET | B | 191 | 2477 | 3301 | 3093 | −107 | 70 | −415 | C |
| ATOM | 4385 | CG | MET | B | 191 | −2.996 | 55.624 | 26.881 | 1.00 | 24.91 | | C |
| ANISOU | 4385 | CG | MET | B | 191 | 2710 | 3576 | 3181 | −103 | 51 | −409 | C |
| ATOM | 4386 | SD | MET | B | 191 | −4.211 | 56.943 | 27.087 | 1.00 | 48.57 | | S |
| ANISOU | 4386 | SD | MET | B | 191 | 5688 | 6582 | 6183 | −71 | 20 | −430 | S |
| ATOM | 4387 | CE | MET | B | 191 | −3.985 | 57.321 | 28.792 | 1.00 | 18.63 | | C |
| ANISOU | 4387 | CE | MET | B | 191 | 1869 | 2812 | 2396 | −33 | −21 | −506 | C |
| ATOM | 4388 | N | SER | B | 192 | 0.859 | 57.759 | 24.717 | 1.00 | 19.87 | | N |
| ANISOU | 4388 | N | SER | B | 192 | 1987 | 2616 | 2948 | −114 | 253 | −297 | N |
| ATOM | 4389 | CA | SER | B | 192 | 2.173 | 58.364 | 24.808 | 1.00 | 23.87 | | C |
| ANISOU | 4389 | CA | SER | B | 192 | 2393 | 3019 | 3658 | −123 | 282 | −273 | C |
| ATOM | 4390 | C | SER | B | 192 | 2.094 | 59.880 | 24.610 | 1.00 | 28.07 | | C |
| ANISOU | 4390 | C | SER | B | 192 | 2896 | 3480 | 4291 | −123 | 269 | −266 | C |
| ATOM | 4391 | O | SER | B | 192 | 1.021 | 60.429 | 24.387 | 1.00 | 26.83 | | O |
| ANISOU | 4391 | O | SER | B | 192 | 2804 | 3358 | 4032 | −109 | 243 | −282 | O |
| ATOM | 4392 | CB | SER | B | 192 | 3.140 | 57.733 | 23.805 | 1.00 | 33.14 | | C |
| ANISOU | 4392 | CB | SER | B | 192 | 3573 | 4130 | 4888 | −115 | 437 | −184 | C |
| ATOM | 4393 | OG | SER | B | 192 | 2.772 | 58.018 | 22.475 | 1.00 | 42.15 | | O |
| ANISOU | 4393 | OG | SER | B | 192 | 4826 | 5240 | 5948 | −89 | 555 | −115 | O |
| ATOM | 4394 | N | LEU | B | 193 | 3.248 | 60.538 | 24.669 | 1.00 | 22.19 | | N |
| ANISOU | 4394 | N | LEU | B | 193 | 2043 | 2620 | 3766 | −139 | 285 | −234 | N |
| ATOM | 4395 | CA | LEU | B | 193 | 3.321 | 61.978 | 24.828 | 1.00 | 26.33 | | C |
| ANISOU | 4395 | CA | LEU | B | 193 | 2514 | 3061 | 4428 | −146 | 229 | −244 | C |
| ATOM | 4396 | C | LEU | B | 193 | 3.512 | 62.725 | 23.521 | 1.00 | 29.60 | | C |
| ANISOU | 4396 | C | LEU | B | 193 | 2948 | 3388 | 4909 | −140 | 377 | −138 | C |
| ATOM | 4397 | O | LEU | B | 193 | 4.009 | 62.168 | 22.544 | 1.00 | 31.37 | | O |
| ANISOU | 4397 | O | LEU | B | 193 | 3204 | 3583 | 5131 | −127 | 541 | −45 | O |
| ATOM | 4398 | CB | LEU | B | 193 | 4.474 | 62.331 | 25.775 | 1.00 | 30.17 | | C |
| ANISOU | 4398 | CB | LEU | B | 193 | 2861 | 3448 | 5154 | −173 | 119 | −273 | C |
| ATOM | 4399 | CG | LEU | B | 193 | 4.493 | 61.585 | 27.105 | 1.00 | 31.21 | | C |
| ANISOU | 4399 | CG | LEU | B | 193 | 2992 | 3640 | 5226 | −170 | −35 | −371 | C |
| ATOM | 4400 | CD1 | LEU | B | 193 | 5.796 | 61.834 | 27.815 | 1.00 | 30.60 | | C |
| ANISOU | 4400 | CD1 | LEU | B | 193 | 2781 | 3435 | 5412 | −196 | −151 | −381 | C |
| ATOM | 4401 | CD2 | LEU | B | 193 | 3.314 | 62.012 | 27.967 | 1.00 | 32.87 | | C |
| ANISOU | 4401 | CD2 | LEU | B | 193 | 3296 | 3927 | 5264 | −139 | −156 | −474 | C |
| ATOM | 4402 | N | SER | B | 194 | 3.154 | 64.005 | 23.542 | 1.00 | 26.90 | | N |
| ANISOU | 4402 | N | SER | B | 194 | 2599 | 2994 | 4627 | −141 | 323 | −150 | N |
| ATOM | 4403 | CA | SER | B | 194 | 3.219 | 64.872 | 22.374 | 1.00 | 26.31 | | C |
| ANISOU | 4403 | CA | SER | B | 194 | 2558 | 2830 | 4607 | −132 | 448 | −50 | C |
| ATOM | 4404 | C | SER | B | 194 | 4.648 | 65.268 | 22.055 | 1.00 | 29.85 | | C |
| ANISOU | 4404 | C | SER | B | 194 | 2875 | 3129 | 5338 | −155 | 553 | 50 | C |
| ATOM | 4405 | O | SER | B | 194 | 5.420 | 65.608 | 22.938 | 1.00 | 38.82 | | O |
| ANISOU | 4405 | O | SER | B | 194 | 3865 | 4191 | 6693 | −190 | 444 | 16 | O |
| ATOM | 4406 | CB | SER | B | 194 | 2.366 | 66.127 | 22.600 | 1.00 | 27.96 | | C |
| ANISOU | 4406 | CB | SER | B | 194 | 2792 | 3025 | 4806 | −125 | 342 | −99 | C |
| ATOM | 4407 | OG | SER | B | 194 | 1.061 | 65.805 | 23.098 | 1.00 | 25.63 | | O |
| ANISOU | 4407 | OG | SER | B | 194 | 2580 | 2859 | 4299 | −101 | 240 | −191 | O |
| ATOM | 4408 | N | LYS | B | 195 | 4.994 | 65.206 | 20.779 | 1.00 | 33.61 | | N |
| ANISOU | 4408 | N | LYS | B | 195 | 3409 | 3547 | 5813 | −130 | 766 | 179 | N |
| ATOM | 4409 | CA | LYS | B | 195 | 6.277 | 65.686 | 20.292 | 1.00 | 34.92 | | C |
| ANISOU | 4409 | CA | LYS | B | 195 | 3450 | 3556 | 6264 | −142 | 919 | 308 | C |
| ATOM | 4410 | C | LYS | B | 195 | 6.100 | 67.145 | 19.826 | 1.00 | 35.43 | | C |
| ANISOU | 4410 | C | LYS | B | 195 | 3517 | 3516 | 6429 | −147 | 936 | 365 | C |
| ATOM | 4411 | O | LYS | B | 195 | 4.982 | 67.553 | 19.497 | 1.00 | 37.38 | | O |
| ANISOU | 4411 | O | LYS | B | 195 | 3911 | 3822 | 6471 | −123 | 890 | 330 | O |
| ATOM | 4412 | CB | LYS | B | 195 | 6.777 | 64.762 | 19.175 | 1.00 | 32.63 | | C |
| ANISOU | 4412 | CB | LYS | B | 195 | 3244 | 3252 | 5903 | −92 | 1175 | 427 | C |
| ATOM | 4413 | CG | LYS | B | 195 | 7.103 | 63.375 | 19.693 | 1.00 | 43.75 | | C |
| ANISOU | 4413 | CG | LYS | B | 195 | 4622 | 4739 | 7262 | −90 | 1153 | 376 | C |
| ATOM | 4414 | CD | LYS | B | 195 | 7.277 | 62.299 | 18.597 | 1.00 | 58.51 | | C |
| ANISOU | 4414 | CD | LYS | B | 195 | 6642 | 6623 | 8967 | −22 | 1382 | 460 | C |
| ATOM | 4415 | CE | LYS | B | 195 | 8.395 | 62.583 | 17.601 | 1.00 | 63.80 | | C |
| ANISOU | 4415 | CE | LYS | B | 195 | 7272 | 7139 | 9830 | 20 | 1669 | 636 | C |
| ATOM | 4416 | NZ | LYS | B | 195 | 8.656 | 61.361 | 16.771 | 1.00 | 55.95 | | N |
| ANISOU | 4416 | NZ | LYS | B | 195 | 6427 | 6160 | 8674 | 99 | 1876 | 694 | N |
| ATOM | 4417 | N | PRO | B | 196 | 7.179 | 67.952 | 19.869 | 1.00 | 35.57 | | N |
| ANISOU | 4417 | N | PRO | B | 196 | 3359 | 3370 | 6787 | −183 | 979 | 450 | N |
| ATOM | 4418 | CA | PRO | B | 196 | 7.104 | 69.379 | 19.537 | 1.00 | 37.61 | | C |
| ANISOU | 4418 | CA | PRO | B | 196 | 3598 | 3510 | 7184 | −197 | 978 | 506 | C |
| ATOM | 4419 | C | PRO | B | 196 | 6.461 | 69.697 | 18.190 | 1.00 | 50.12 | | C |
| ANISOU | 4419 | C | PRO | B | 196 | 5383 | 5094 | 8567 | −140 | 1161 | 605 | C |
| ATOM | 4420 | O | PRO | B | 196 | 5.643 | 70.606 | 18.137 | 1.00 | 58.47 | | O |
| ANISOU | 4420 | O | PRO | B | 196 | 6515 | 6150 | 9552 | −137 | 1064 | 569 | O |
| ATOM | 4421 | CB | PRO | B | 196 | 8.565 | 69.806 | 19.572 | 1.00 | 37.42 | | C |
| ANISOU | 4421 | CB | PRO | B | 196 | 3341 | 3297 | 7578 | −240 | 1060 | 624 | C |
| ATOM | 4422 | CG | PRO | B | 196 | 9.122 | 68.983 | 20.652 | 1.00 | 33.60 | | C |
| ANISOU | 4422 | CG | PRO | B | 196 | 2724 | 2846 | 7195 | −272 | 911 | 534 | C |
| ATOM | 4423 | CD | PRO | B | 196 | 8.463 | 67.636 | 20.510 | 1.00 | 31.96 | | C |
| ANISOU | 4423 | CD | PRO | B | 196 | 2683 | 2823 | 6639 | −224 | 958 | 473 | C |
| ATOM | 4424 | N | GLN | B | 197 | 6.796 | 68.973 | 17.126 | 1.00 | 57.10 | | N |
| ANISOU | 4424 | N | GLN | B | 197 | 6373 | 5971 | 9351 | −86 | 1411 | 724 | N |
| ATOM | 4425 | CA | GLN | B | 197 | 6.170 | 69.279 | 15.845 | 1.00 | 59.05 | | C |
| ANISOU | 4425 | CA | GLN | B | 197 | 6855 | 6204 | 9379 | −20 | 1562 | 814 | C |
| ATOM | 4426 | C | GLN | B | 197 | 5.109 | 68.244 | 15.500 | 1.00 | 51.39 | | C |
| ANISOU | 4426 | C | GLN | B | 197 | 6117 | 5387 | 8022 | 33 | 1518 | 735 | C |
| ATOM | 4427 | O | GLN | B | 197 | 4.720 | 68.096 | 14.341 | 1.00 | 51.29 | | O |
| ANISOU | 4427 | O | GLN | B | 197 | 6337 | 5361 | 7790 | 104 | 1653 | 812 | O |
| ATOM | 4428 | CB | GLN | B | 197 | 7.226 | 69.335 | 14.732 | 1.00 | 69.54 | | C |
| ANISOU | 4428 | CB | GLN | B | 197 | 8196 | 7386 | 10838 | 27 | 1894 | 1020 | C |
| ATOM | 4429 | CG | GLN | B | 197 | 8.248 | 70.468 | 14.874 | 1.00 | 80.72 | | C |
| ANISOU | 4429 | CG | GLN | B | 197 | 9379 | 8619 | 12673 | −25 | 1963 | 1136 | C |
| ATOM | 4430 | CD | GLN | B | 197 | 7.614 | 71.851 | 14.804 | 1.00 | 91.28 | | C |
| ANISOU | 4430 | CD | GLN | B | 197 | 10750 | 9897 | 14036 | −46 | 1850 | 1132 | C |
| ATOM | 4431 | OE1 | GLN | B | 197 | 7.343 | 72.471 | 15.833 | 1.00 | 92.60 | | O |
| ANISOU | 4431 | OE1 | GLN | B | 197 | 10787 | 10072 | 14325 | −112 | 1591 | 1010 | O |
| ATOM | 4432 | NE2 | GLN | B | 197 | 7.389 | 72.346 | 13.588 | 1.00 | 95.88 | | N |
| ANISOU | 4432 | NE2 | GLN | B | 197 | 11524 | 10409 | 14497 | 18 | 2046 | 1268 | N |
| ATOM | 4433 | N | GLY | B | 198 | 4.596 | 67.581 | 16.532 | 1.00 | 45.36 | | N |
| ANISOU | 4433 | N | GLY | B | 198 | 5300 | 4755 | 7178 | −1 | 1311 | 582 | N |
| ATOM | 4434 | CA | GLY | B | 198 | 3.641 | 66.504 | 16.357 | 1.00 | 40.05 | | C |
| ANISOU | 4434 | CA | GLY | B | 198 | 4804 | 4221 | 6192 | 34 | 1249 | 507 | C |
| ATOM | 4435 | C | GLY | B | 198 | 2.220 | 66.805 | 16.790 | 1.00 | 39.28 | | C |
| ANISOU | 4435 | C | GLY | B | 198 | 4769 | 4222 | 5932 | 25 | 1024 | 389 | C |
| ATOM | 4436 | O | GLY | B | 198 | 1.914 | 67.874 | 17.318 | 1.00 | 38.00 | | O |
| ANISOU | 4436 | O | GLY | B | 198 | 4522 | 4035 | 5881 | −3 | 907 | 348 | O |
| ATOM | 4437 | N | ILE | B | 199 | 1.337 | 65.844 | 16.550 | 1.00 | 36.18 | | N |
| ANISOU | 4437 | N | ILE | B | 199 | 4525 | 3934 | 5289 | 53 | 965 | 338 | N |
| ATOM | 4438 | CA | ILE | B | 199 | −0.055 | 65.948 | 16.947 | 1.00 | 29.07 | | C |
| ANISOU | 4438 | CA | ILE | B | 199 | 3665 | 3128 | 4253 | 48 | 765 | 238 | C |
| ATOM | 4439 | C | ILE | B | 199 | −0.221 | 65.873 | 18.457 | 1.00 | 32.49 | | C |
| ANISOU | 4439 | C | ILE | B | 199 | 3921 | 3645 | 4778 | 1 | 610 | 116 | C |
| ATOM | 4440 | O | ILE | B | 199 | 0.300 | 64.961 | 19.088 | 1.00 | 37.48 | | O |
| ANISOU | 4440 | O | ILE | B | 199 | 4480 | 4327 | 5433 | −20 | 612 | 79 | O |
| ATOM | 4441 | CB | ILE | B | 199 | −0.900 | 64.841 | 16.297 | 1.00 | 28.15 | | C |
| ANISOU | 4441 | CB | ILE | B | 199 | 3737 | 3079 | 3879 | 85 | 731 | 226 | C |
| ATOM | 4442 | CG1 | ILE | B | 199 | −0.749 | 64.899 | 14.767 | 1.00 | 26.82 | | C |
| ANISOU | 4442 | CG1 | ILE | B | 199 | 3802 | 2812 | 3578 | 152 | 875 | 343 | C |
| ATOM | 4443 | CG2 | ILE | B | 199 | −2.367 | 64.942 | 16.758 | 1.00 | 24.64 | | C |
| ANISOU | 4443 | CG2 | ILE | B | 199 | 3294 | 2721 | 3348 | 76 | 524 | 137 | C |
| ATOM | 4444 | CD1 | ILE | B | 199 | −1.237 | 63.648 | 14.060 | 1.00 | 26.79 | | C |
| ANISOU | 4444 | CD1 | ILE | B | 199 | 4007 | 2840 | 3331 | 195 | 857 | 337 | C |
| ATOM | 4445 | N | PRO | B | 200 | −0.953 | 66.827 | 19.046 | 1.00 | 31.90 | | N |
| ANISOU | 4445 | N | PRO | B | 200 | 3795 | 3581 | 4747 | −6 | 478 | 53 | N |
| ATOM | 4446 | CA | PRO | B | 200 | −1.255 | 66.691 | 20.473 | 1.00 | 32.22 | | C |
| ANISOU | 4446 | CA | PRO | B | 200 | 3718 | 3703 | 4822 | −28 | 339 | −67 | C |
| ATOM | 4447 | C | PRO | B | 200 | −1.999 | 65.398 | 20.810 | 1.00 | 32.83 | | C |
| ANISOU | 4447 | C | PRO | B | 200 | 3834 | 3908 | 4730 | −23 | 286 | −121 | C |
| ATOM | 4448 | O | PRO | B | 200 | −3.033 | 65.059 | 20.242 | 1.00 | 31.08 | | O |
| ANISOU | 4448 | O | PRO | B | 200 | 3713 | 3732 | 4365 | −2 | 253 | −113 | O |
| ATOM | 4449 | CB | PRO | B | 200 | −2.116 | 67.922 | 20.760 | 1.00 | 24.73 | | C |
| ANISOU | 4449 | CB | PRO | B | 200 | 2759 | 2734 | 3904 | −11 | 236 | −110 | C |
| ATOM | 4450 | CG | PRO | B | 200 | −1.589 | 68.939 | 19.792 | 1.00 | 25.09 | | C |
| ANISOU | 4450 | CG | PRO | B | 200 | 2837 | 2647 | 4050 | −7 | 325 | −9 | C |
| ATOM | 4451 | CD | PRO | B | 200 | −1.365 | 68.138 | 18.530 | 1.00 | 27.22 | | C |
| ANISOU | 4451 | CD | PRO | B | 200 | 3242 | 2907 | 4195 | 12 | 464 | 92 | C |
| ATOM | 4452 | N | THR | B | 201 | −1.444 | 64.666 | 21.759 | 1.00 | 24.53 | | N |
| ANISOU | 4452 | N | THR | B | 201 | 2699 | 2904 | 3716 | −45 | 265 | −174 | N |
| ATOM | 4453 | CA | THR | B | 201 | −1.979 | 63.374 | 22.074 | 1.00 | 21.50 | | C |
| ANISOU | 4453 | CA | THR | B | 201 | 2346 | 2629 | 3194 | −46 | 234 | −210 | C |
| ATOM | 4454 | C | THR | B | 201 | −3.004 | 63.484 | 23.165 | 1.00 | 27.61 | | C |
| ANISOU | 4454 | C | THR | B | 201 | 3079 | 3485 | 3928 | −34 | 118 | −297 | C |
| ATOM | 4455 | O | THR | B | 201 | −3.070 | 64.492 | 23.875 | 1.00 | 26.71 | | O |
| ANISOU | 4455 | O | THR | B | 201 | 2911 | 3342 | 3896 | −22 | 61 | −347 | O |
| ATOM | 4456 | CB | THR | B | 201 | −0.855 | 62.400 | 22.507 | 1.00 | 29.02 | | C |
| ANISOU | 4456 | CB | THR | B | 201 | 3243 | 3589 | 4196 | −68 | 280 | −212 | C |
| ATOM | 4457 | OG1 | THR | B | 201 | −0.237 | 62.870 | 23.711 | 1.00 | 27.25 | | O |
| ANISOU | 4457 | OG1 | THR | B | 201 | 2902 | 3341 | 4109 | −84 | 205 | −274 | O |
| ATOM | 4458 | CG2 | THR | B | 201 | 0.199 | 62.290 | 21.413 | 1.00 | 25.07 | | C |
| ANISOU | 4458 | CG2 | THR | B | 201 | 2775 | 2997 | 3754 | −65 | 433 | −111 | C |
| ATOM | 4459 | N | PHE | B | 202 | −3.793 | 62.424 | 23.298 | 1.00 | 22.48 | | N |
| ANISOU | 4459 | N | PHE | B | 202 | 2459 | 2926 | 3157 | −33 | 92 | −311 | N |
| ATOM | 4460 | CA | PHE | B | 202 | −4.854 | 62.348 | 24.286 | 1.00 | 22.29 | | C |
| ANISOU | 4460 | CA | PHE | B | 202 | 2396 | 2981 | 3093 | −13 | 19 | −371 | C |
| ATOM | 4461 | C | PHE | B | 202 | −4.377 | 62.657 | 25.707 | 1.00 | 26.02 | | C |
| ANISOU | 4461 | C | PHE | B | 202 | 2805 | 3463 | 3620 | 0 | −17 | −449 | C |
| ATOM | 4462 | O | PHE | B | 202 | −5.053 | 63.348 | 26.453 | 1.00 | 30.92 | | O |
| ANISOU | 4462 | O | PHE | B | 202 | 3409 | 4096 | 4244 | 39 | −59 | −499 | O |
| ATOM | 4463 | CB | PHE | B | 202 | −5.494 | 60.959 | 24.239 | 1.00 | 25.61 | | C |
| ANISOU | 4463 | CB | PHE | B | 202 | 2841 | 3481 | 3410 | −26 | 11 | −356 | C |
| ATOM | 4464 | CG | PHE | B | 202 | −6.550 | 60.739 | 25.280 | 1.00 | 29.82 | | C |
| ANISOU | 4464 | CG | PHE | B | 202 | 3320 | 4090 | 3918 | −3 | −28 | −395 | C |
| ATOM | 4465 | CD2 | PHE | B | 202 | −6.230 | 60.153 | 26.500 | 1.00 | 19.29 | | C |
| ANISOU | 4465 | CD2 | PHE | B | 202 | 1954 | 2810 | 2565 | 2 | −22 | −441 | C |
| ATOM | 4466 | CD1 | PHE | B | 202 | −7.873 | 61.089 | 25.026 | 1.00 | 24.42 | | C |
| ANISOU | 4466 | CD1 | PHE | B | 202 | 2621 | 3417 | 3239 | 19 | −65 | −376 | C |
| ATOM | 4467 | CE2 | PHE | B | 202 | −7.212 | 59.953 | 27.457 | 1.00 | 25.04 | | C |
| ANISOU | 4467 | CE2 | PHE | B | 202 | 2649 | 3602 | 3263 | 37 | −24 | −462 | C |
| ATOM | 4468 | CE1 | PHE | B | 202 | −8.858 | 60.894 | 25.971 | 1.00 | 19.95 | | C |
| ANISOU | 4468 | CE1 | PHE | B | 202 | 1991 | 2912 | 2676 | 49 | −67 | −393 | C |
| ATOM | 4469 | CZ | PHE | B | 202 | −8.535 | 60.326 | 27.189 | 1.00 | 25.73 | | C |
| ANISOU | 4469 | CZ | PHE | B | 202 | 2705 | 3699 | 3373 | 61 | −33 | −433 | C |
| ATOM | 4470 | N | VAL | B | 203 | −3.221 | 62.132 | 26.088 | 1.00 | 25.90 | | N |
| ANISOU | 4470 | N | VAL | B | 203 | 2765 | 3431 | 3644 | −24 | −6 | −459 | N |
| ATOM | 4471 | CA | VAL | B | 203 | −2.786 | 62.244 | 27.474 | 1.00 | 28.05 | | C |
| ANISOU | 4471 | CA | VAL | B | 203 | 3007 | 3705 | 3945 | −7 | −74 | −538 | C |
| ATOM | 4472 | C | VAL | B | 203 | −2.396 | 63.678 | 27.809 | 1.00 | 29.85 | | C |
| ANISOU | 4472 | C | VAL | B | 203 | 3213 | 3836 | 4292 | 10 | −135 | −579 | C |
| ATOM | 4473 | O | VAL | B | 203 | −2.747 | 64.187 | 28.863 | 1.00 | 21.45 | | O |
| ANISOU | 4473 | O | VAL | B | 203 | 2171 | 2774 | 3205 | 55 | −205 | −657 | O |
| ATOM | 4474 | CB | VAL | B | 203 | −1.607 | 61.310 | 27.786 | 1.00 | 27.37 | | C |
| ANISOU | 4474 | CB | VAL | B | 203 | 2894 | 3609 | 3894 | −38 | −76 | −536 | C |
| ATOM | 4475 | CG1 | VAL | B | 203 | −1.125 | 61.541 | 29.185 | 1.00 | 26.34 | | C |
| ANISOU | 4475 | CG1 | VAL | B | 203 | 2757 | 3457 | 3796 | −15 | −181 | −620 | C |
| ATOM | 4476 | CG2 | VAL | B | 203 | −2.074 | 59.914 | 27.711 | 1.00 | 35.91 | | C |
| ANISOU | 4476 | CG2 | VAL | B | 203 | 4007 | 4785 | 4853 | −47 | −37 | −512 | C |
| ATOM | 4477 | N | ASN | B | 204 | −1.654 | 64.320 | 26.916 | 1.00 | 28.90 | | N |
| ANISOU | 4477 | N | ASN | B | 204 | 3062 | 3620 | 4298 | −21 | −102 | −524 | N |
| ATOM | 4478 | CA | ASN | B | 204 | −1.311 | 65.716 | 27.118 | 1.00 | 25.31 | | C |
| ANISOU | 4478 | CA | ASN | B | 204 | 2580 | 3057 | 3981 | −13 | −164 | −552 | C |
| ATOM | 4479 | C | ASN | B | 204 | −2.536 | 66.616 | 27.115 | 1.00 | 29.19 | | C |
| ANISOU | 4479 | C | ASN | B | 204 | 3115 | 3563 | 4413 | 35 | −184 | −579 | C |
| ATOM | 4480 | O | ASN | B | 204 | −2.649 | 67.496 | 27.956 | 1.00 | 23.03 | | O |
| ANISOU | 4480 | O | ASN | B | 204 | 2344 | 2737 | 3669 | 73 | −270 | −655 | O |
| ATOM | 4481 | CB | ASN | B | 204 | −0.323 | 66.177 | 26.059 | 1.00 | 27.02 | | C |
| ANISOU | 4481 | CB | ASN | B | 204 | 2746 | 3162 | 4359 | −56 | −93 | −461 | C |
| ATOM | 4482 | CG | ASN | B | 204 | 1.032 | 65.554 | 26.242 | 1.00 | 33.01 | | C |
| ANISOU | 4482 | CG | ASN | B | 204 | 3427 | 3870 | 5246 | −94 | −84 | −437 | C |
| ATOM | 4483 | OD1 | ASN | B | 204 | 1.596 | 64.994 | 25.322 | 1.00 | 43.14 | | O |
| ANISOU | 4483 | OD1 | ASN | B | 204 | 4694 | 5136 | 6560 | −116 | 40 | −346 | O |
| ATOM | 4484 | ND2 | ASN | B | 204 | 1.554 | 65.633 | 27.451 | 1.00 | 35.83 | | N |
| ANISOU | 4484 | ND2 | ASN | B | 204 | 3746 | 4192 | 5674 | −93 | −220 | −519 | N |
| ATOM | 4485 | N | LEU | B | 205 | −3.461 | 66.365 | 26.192 | 1.00 | 29.88 | | N |
| ANISOU | 4485 | N | LEU | B | 205 | 3235 | 3706 | 4411 | 39 | −117 | −521 | N |
| ATOM | 4486 | CA | LEU | B | 205 | −4.711 | 67.112 | 26.124 | 1.00 | 25.09 | | C |
| ANISOU | 4486 | CA | LEU | B | 205 | 2653 | 3115 | 3765 | 86 | −136 | −535 | C |
| ATOM | 4487 | C | LEU | B | 205 | −5.589 | 66.901 | 27.366 | 1.00 | 27.31 | | C |
| ANISOU | 4487 | C | LEU | B | 205 | 2942 | 3474 | 3961 | 145 | −169 | −613 | C |
| ATOM | 4488 | O | LEU | B | 205 | −6.177 | 67.852 | 27.870 | 1.00 | 33.03 | | O |
| ANISOU | 4488 | O | LEU | B | 205 | 3677 | 4171 | 4702 | 203 | −203 | −662 | O |
| ATOM | 4489 | CB | LEU | B | 205 | −5.471 | 66.748 | 24.846 | 1.00 | 21.86 | | C |
| ANISOU | 4489 | CB | LEU | B | 205 | 2282 | 2734 | 3290 | 76 | −87 | −450 | C |
| ATOM | 4490 | CG | LEU | B | 205 | −4.869 | 67.351 | 23.568 | 1.00 | 24.72 | | C |
| ANISOU | 4490 | CG | LEU | B | 205 | 2679 | 2997 | 3716 | 51 | −41 | −368 | C |
| ATOM | 4491 | CD1 | LEU | B | 205 | −5.614 | 66.886 | 22.314 | 1.00 | 22.23 | | C |
| ANISOU | 4491 | CD1 | LEU | B | 205 | 2448 | 2699 | 3299 | 53 | −17 | −292 | C |
| ATOM | 4492 | CD2 | LEU | B | 205 | −4.838 | 68.915 | 23.637 | 1.00 | 23.11 | | C |
| ANISOU | 4492 | CD2 | LEU | B | 205 | 2458 | 2693 | 3631 | 72 | −80 | −383 | C |
| ATOM | 4493 | N | LEU | B | 206 | −5.699 | 65.670 | 27.855 | 1.00 | 23.38 | | N |
| ANISOU | 4493 | N | LEU | B | 206 | 2445 | 3066 | 3371 | 140 | −146 | −619 | N |
| ATOM | 4494 | CA | LEU | B | 206 | −6.470 | 65.432 | 29.075 | 1.00 | 24.49 | | C |
| ANISOU | 4494 | CA | LEU | B | 206 | 2605 | 3273 | 3427 | 205 | −147 | −677 | C |
| ATOM | 4495 | C | LEU | B | 206 | −5.928 | 66.298 | 30.198 | 1.00 | 25.02 | | C |
| ANISOU | 4495 | C | LEU | B | 206 | 2717 | 3272 | 3518 | 256 | −218 | −773 | C |
| ATOM | 4496 | O | LEU | B | 206 | −6.705 | 66.959 | 30.878 | 1.00 | 23.75 | | O |
| ANISOU | 4496 | O | LEU | B | 206 | 2594 | 3108 | 3323 | 337 | −217 | −823 | O |
| ATOM | 4497 | CB | LEU | B | 206 | −6.443 | 63.953 | 29.507 | 1.00 | 29.01 | | C |
| ANISOU | 4497 | CB | LEU | B | 206 | 3180 | 3936 | 3908 | 186 | −114 | −664 | C |
| ATOM | 4498 | CG | LEU | B | 206 | −7.079 | 63.496 | 30.841 | 1.00 | 23.34 | | C |
| ANISOU | 4498 | CG | LEU | B | 206 | 2495 | 3283 | 3089 | 255 | −87 | −707 | C |
| ATOM | 4499 | CD1 | LEU | B | 206 | −8.572 | 63.646 | 30.861 | 1.00 | 21.91 | | C |
| ANISOU | 4499 | CD1 | LEU | B | 206 | 2283 | 3148 | 2894 | 309 | −19 | −675 | C |
| ATOM | 4500 | CD2 | LEU | B | 206 | −6.735 | 62.035 | 31.137 | 1.00 | 21.04 | | C |
| ANISOU | 4500 | CD2 | LEU | B | 206 | 2209 | 3059 | 2727 | 219 | −65 | −683 | C |
| ATOM | 4501 | N | PHE | B | 207 | −4.609 | 66.310 | 30.395 | 1.00 | 22.73 | | N |
| ANISOU | 4501 | N | PHE | B | 207 | 2427 | 2913 | 3296 | 216 | −287 | −799 | N |
| ATOM | 4502 | CA | PHE | B | 207 | −4.074 | 67.056 | 31.532 | 1.00 | 34.93 | | C |
| ANISOU | 4502 | CA | PHE | B | 207 | 4034 | 4375 | 4864 | 265 | −398 | −899 | C |
| ATOM | 4503 | C | PHE | B | 207 | −4.114 | 68.579 | 31.276 | 1.00 | 31.75 | | C |
| ANISOU | 4503 | C | PHE | B | 207 | 3631 | 3859 | 4572 | 286 | −452 | −925 | C |
| ATOM | 4504 | O | PHE | B | 207 | −4.355 | 69.343 | 32.204 | 1.00 | 27.76 | | O |
| ANISOU | 4504 | O | PHE | B | 207 | 3209 | 3303 | 4036 | 366 | −521 | −1015 | O |
| ATOM | 4505 | CB | PHE | B | 207 | −2.655 | 66.558 | 31.896 | 1.00 | 31.45 | | C |
| ANISOU | 4505 | CB | PHE | B | 207 | 3578 | 3879 | 4494 | 215 | −487 | −917 | C |
| ATOM | 4506 | CG | PHE | B | 207 | −2.665 | 65.188 | 32.544 | 1.00 | 29.48 | | C |
| ANISOU | 4506 | CG | PHE | B | 207 | 3364 | 3725 | 4113 | 222 | −464 | −921 | C |
| ATOM | 4507 | CD1 | PHE | B | 207 | −3.217 | 65.009 | 33.804 | 1.00 | 24.44 | | C |
| ANISOU | 4507 | CD1 | PHE | B | 207 | 2840 | 3125 | 3321 | 311 | −484 | −993 | C |
| ATOM | 4508 | CD2 | PHE | B | 207 | −2.214 | 64.063 | 31.852 | 1.00 | 33.20 | | C |
| ANISOU | 4508 | CD2 | PHE | B | 207 | 3767 | 4248 | 4601 | 150 | −402 | −845 | C |
| ATOM | 4509 | CE1 | PHE | B | 207 | −3.284 | 63.730 | 34.390 | 1.00 | 26.16 | | C |
| ANISOU | 4509 | CE1 | PHE | B | 207 | 3096 | 3429 | 3413 | 320 | −449 | −983 | C |
| ATOM | 4510 | CE2 | PHE | B | 207 | −2.273 | 62.772 | 32.425 | 1.00 | 26.22 | | C |
| ANISOU | 4510 | CE2 | PHE | B | 207 | 2915 | 3449 | 3598 | 156 | −380 | −843 | C |
| ATOM | 4511 | CZ | PHE | B | 207 | −2.804 | 62.606 | 33.688 | 1.00 | 23.70 | | C |
| ANISOU | 4511 | CZ | PHE | B | 207 | 2701 | 3167 | 3136 | 236 | −405 | −908 | C |
| ATOM | 4512 | N | ASP | B | 208 | −3.923 | 69.009 | 30.028 | 1.00 | 28.50 | | N |
| ANISOU | 4512 | N | ASP | B | 208 | 3149 | 3404 | 4275 | 226 | −415 | −845 | N |
| ATOM | 4513 | CA | ASP | B | 208 | −3.979 | 70.427 | 29.698 | 1.00 | 33.85 | | C |
| ANISOU | 4513 | CA | ASP | B | 208 | 3824 | 3971 | 5066 | 241 | −459 | −855 | C |
| ATOM | 4514 | C | ASP | B | 208 | −5.348 | 70.952 | 30.050 | 1.00 | 41.28 | | C |
| ANISOU | 4514 | C | ASP | B | 208 | 4817 | 4953 | 5913 | 333 | −432 | −894 | C |
| ATOM | 4515 | O | ASP | B | 208 | −5.475 | 72.065 | 30.560 | 1.00 | 42.54 | | O |
| ANISOU | 4515 | O | ASP | B | 208 | 5024 | 5025 | 6113 | 392 | −502 | −963 | O |
| ATOM | 4516 | CB | ASP | B | 208 | −3.696 | 70.705 | 28.220 | 1.00 | 28.38 | | C |
| ANISOU | 4516 | CB | ASP | B | 208 | 3068 | 3235 | 4481 | 172 | −393 | −742 | C |
| ATOM | 4517 | CG | ASP | B | 208 | −2.273 | 70.382 | 27.824 | 1.00 | 35.46 | | C |
| ANISOU | 4517 | CG | ASP | B | 208 | 3900 | 4061 | 5513 | 93 | −391 | −689 | C |
| ATOM | 4518 | OD1 | ASP | B | 208 | −1.451 | 70.072 | 28.716 | 1.00 | 38.61 | | O |
| ANISOU | 4518 | OD1 | ASP | B | 208 | 4286 | 4429 | 5956 | 83 | −476 | −746 | O |
| ATOM | 4519 | OD2 | ASP | B | 208 | −1.968 | 70.464 | 26.615 | 1.00 | 38.81 | | O |
| ANISOU | 4519 | OD2 | ASP | B | 208 | 4291 | 4450 | 6007 | 47 | −303 | −584 | O |
| ATOM | 4520 | N | ASN | B | 209 | −6.366 | 70.131 | 29.798 | 1.00 | 36.51 | | N |
| ANISOU | 4520 | N | ASN | B | 209 | 4198 | 4472 | 5201 | 348 | −334 | −847 | N |
| ATOM | 4521 | CA | ASN | B | 209 | −7.742 | 70.524 | 30.074 | 1.00 | 34.86 | | C |
| ANISOU | 4521 | CA | ASN | B | 209 | 4005 | 4303 | 4937 | 437 | −287 | −862 | C |
| ATOM | 4522 | C | ASN | B | 209 | −8.203 | 70.136 | 31.453 | 1.00 | 29.42 | | C |
| ANISOU | 4522 | C | ASN | B | 209 | 3385 | 3668 | 4124 | 529 | −258 | −934 | C |
| ATOM | 4523 | O | ASN | B | 209 | −9.349 | 70.365 | 31.803 | 1.00 | 30.35 | | O |
| ANISOU | 4523 | O | ASN | B | 209 | 3511 | 3820 | 4203 | 617 | −188 | −938 | O |
| ATOM | 4524 | CB | ASN | B | 209 | −8.692 | 69.920 | 29.044 | 1.00 | 30.81 | | C |
| ANISOU | 4524 | CB | ASN | B | 209 | 3426 | 3870 | 4412 | 408 | −211 | −761 | C |
| ATOM | 4525 | CG | ASN | B | 209 | −8.542 | 70.563 | 27.690 | 1.00 | 35.53 | | C |
| ANISOU | 4525 | CG | ASN | B | 209 | 4000 | 4398 | 5102 | 355 | −233 | −691 | C |
| ATOM | 4526 | OD1 | ASN | B | 209 | −9.123 | 71.619 | 27.422 | 1.00 | 41.44 | | O |
| ANISOU | 4526 | OD1 | ASN | B | 209 | 4747 | 5087 | 5910 | 397 | −253 | −691 | O |
| ATOM | 4527 | ND2 | ASN | B | 209 | −7.747 | 69.950 | 26.834 | 1.00 | 31.35 | | N |
| ANISOU | 4527 | ND2 | ASN | B | 209 | 3464 | 3866 | 4582 | 272 | −221 | −628 | N |
| ATOM | 4528 | N | ALA | B | 210 | −7.301 | 69.570 | 32.245 | 1.00 | 31.21 | | N |
| ANISOU | 4528 | N | ALA | B | 210 | 3669 | 3893 | 4297 | 519 | −309 | −985 | N |
| ATOM | 4529 | CA | ALA | B | 210 | −7.618 | 69.260 | 33.629 | 1.00 | 33.68 | | C |
| ANISOU | 4529 | CA | ALA | B | 210 | 4093 | 4237 | 4467 | 621 | −289 | −1058 | C |
| ATOM | 4530 | C | ALA | B | 210 | −6.501 | 69.723 | 34.563 | 1.00 | 37.87 | | C |
| ANISOU | 4530 | C | ALA | B | 210 | 4741 | 4658 | 4990 | 646 | −441 | −1166 | C |
| ATOM | 4531 | O | ALA | B | 210 | −5.810 | 68.910 | 35.178 | 1.00 | 39.24 | | O |
| ANISOU | 4531 | O | ALA | B | 210 | 4963 | 4846 | 5098 | 631 | −489 | −1190 | O |
| ATOM | 4532 | CB | ALA | B | 210 | −7.887 | 67.787 | 33.791 | 1.00 | 25.46 | | C |
| ANISOU | 4532 | CB | ALA | B | 210 | 3026 | 3319 | 3329 | 598 | −198 | −1002 | C |
| ATOM | 4533 | N | PRO | B | 211 | −6.339 | 71.052 | 34.683 | 1.00 | 36.74 | | N |
| ANISOU | 4533 | N | PRO | B | 211 | 4647 | 4390 | 4922 | 686 | −535 | −1233 | N |
| ATOM | 4534 | CA | PRO | B | 211 | −5.300 | 71.686 | 35.500 | 1.00 | 32.31 | | C |
| ANISOU | 4534 | CA | PRO | B | 211 | 4199 | 3686 | 4391 | 708 | −725 | −1341 | C |
| ATOM | 4535 | C | PRO | B | 211 | −5.437 | 71.374 | 36.984 | 1.00 | 36.41 | | C |
| ANISOU | 4535 | C | PRO | B | 211 | 4918 | 4206 | 4708 | 834 | −754 | −1440 | C |
| ATOM | 4536 | O | PRO | B | 211 | −4.491 | 71.614 | 37.734 | 1.00 | 38.73 | | O |
| ANISOU | 4536 | O | PRO | B | 211 | 5326 | 4385 | 5007 | 848 | −942 | −1531 | O |
| ATOM | 4537 | CB | PRO | B | 211 | −5.528 | 73.174 | 35.258 | 1.00 | 32.09 | | C |
| ANISOU | 4537 | CB | PRO | B | 211 | 4186 | 3538 | 4467 | 746 | −782 | −1381 | C |
| ATOM | 4538 | CG | PRO | B | 211 | −6.970 | 73.265 | 34.950 | 1.00 | 39.97 | | C |
| ANISOU | 4538 | CG | PRO | B | 211 | 5156 | 4632 | 5399 | 816 | −606 | −1333 | C |
| ATOM | 4539 | CD | PRO | B | 211 | −7.287 | 72.040 | 34.146 | 1.00 | 28.37 | | C |
| ANISOU | 4539 | CD | PRO | B | 211 | 3553 | 3309 | 3918 | 731 | −476 | −1214 | C |
| ATOM | 4540 | N | GLN | B | 212 | −6.597 | 70.876 | 37.411 | 1.00 | 32.72 | | N |
| ANISOU | 4540 | N | GLN | B | 212 | 4503 | 3853 | 4078 | 930 | −577 | −1418 | N |
| ATOM | 4541 | CA | GLN | B | 212 | −6.775 | 70.527 | 38.814 | 1.00 | 31.63 | | C |
| ANISOU | 4541 | CA | GLN | B | 212 | 4579 | 3716 | 3724 | 1065 | −567 | −1495 | C |
| ATOM | 4542 | C | GLN | B | 212 | −6.078 | 69.210 | 39.144 | 1.00 | 32.69 | | C |
| ANISOU | 4542 | C | GLN | B | 212 | 4723 | 3911 | 3788 | 1006 | −599 | −1471 | C |
| ATOM | 4543 | O | GLN | B | 212 | −5.956 | 68.854 | 40.317 | 1.00 | 35.16 | | O |
| ANISOU | 4543 | O | GLN | B | 212 | 5235 | 4206 | 3920 | 1105 | −631 | −1536 | O |
| ATOM | 4544 | CB | GLN | B | 212 | −8.269 | 70.472 | 39.180 | 1.00 | 32.17 | | C |
| ANISOU | 4544 | CB | GLN | B | 212 | 4688 | 3871 | 3664 | 1198 | −334 | −1461 | C |
| ATOM | 4545 | CG | GLN | B | 212 | −9.094 | 69.387 | 38.499 | 1.00 | 30.85 | | C |
| ANISOU | 4545 | CG | GLN | B | 212 | 4338 | 3862 | 3521 | 1136 | −138 | −1321 | C |
| ATOM | 4546 | CD | GLN | B | 212 | −9.544 | 69.762 | 37.101 | 1.00 | 33.18 | | C |
| ANISOU | 4546 | CD | GLN | B | 212 | 4419 | 4181 | 4006 | 1040 | −104 | −1236 | C |
| ATOM | 4547 | OE1 | GLN | B | 212 | −8.949 | 70.621 | 36.447 | 1.00 | 35.30 | | O |
| ANISOU | 4547 | OE1 | GLN | B | 212 | 4645 | 4362 | 4405 | 976 | −232 | −1262 | O |
| ATOM | 4548 | NE2 | GLN | B | 212 | −10.613 | 69.129 | 36.640 | 1.00 | 30.79 | | N |
| ANISOU | 4548 | NE2 | GLN | B | 212 | 3987 | 3985 | 3728 | 1032 | 62 | −1129 | N |
| ATOM | 4549 | N | LEU | B | 213 | −5.591 | 68.521 | 38.111 | 1.00 | 29.47 | | N |
| ANISOU | 4549 | N | LEU | B | 213 | 4119 | 3561 | 3516 | 854 | −594 | −1379 | N |
| ATOM | 4550 | CA | LEU | B | 213 | −4.894 | 67.238 | 38.263 | 1.00 | 30.77 | | C |
| ANISOU | 4550 | CA | LEU | B | 213 | 4265 | 3782 | 3645 | 786 | −620 | −1346 | C |
| ATOM | 4551 | C | LEU | B | 213 | −3.391 | 67.360 | 38.037 | 1.00 | 33.14 | | C |
| ANISOU | 4551 | C | LEU | B | 213 | 4514 | 3971 | 4108 | 685 | −830 | −1374 | C |
| ATOM | 4552 | O | LEU | B | 213 | −2.947 | 68.066 | 37.128 | 1.00 | 32.96 | | O |
| ANISOU | 4552 | O | LEU | B | 213 | 4363 | 3879 | 4281 | 603 | −879 | −1349 | O |
| ATOM | 4553 | CB | LEU | B | 213 | −5.443 | 66.182 | 37.276 | 1.00 | 30.56 | | C |
| ANISOU | 4553 | CB | LEU | B | 213 | 4062 | 3899 | 3651 | 697 | −450 | −1214 | C |
| ATOM | 4554 | CG | LEU | B | 213 | −6.922 | 65.748 | 37.254 | 1.00 | 31.20 | | C |
| ANISOU | 4554 | CG | LEU | B | 213 | 4115 | 4099 | 3641 | 756 | −237 | −1143 | C |
| ATOM | 4555 | CD1 | LEU | B | 213 | −7.159 | 64.746 | 36.135 | 1.00 | 25.48 | | C |
| ANISOU | 4555 | CD1 | LEU | B | 213 | 3215 | 3474 | 2993 | 640 | −151 | −1025 | C |
| ATOM | 4556 | CD2 | LEU | B | 213 | −7.384 | 65.155 | 38.577 | 1.00 | 32.24 | | C |
| ANISOU | 4556 | CD2 | LEU | B | 213 | 4411 | 4270 | 3569 | 879 | −155 | −1168 | C |
| ATOM | 4557 | N | LYS | B | 214 | −2.614 | 66.624 | 38.829 | 1.00 | 29.25 | | N |
| ANISOU | 4557 | N | LYS | B | 214 | 4109 | 3454 | 3548 | 690 | −942 | −1411 | N |
| ATOM | 4558 | CA | LYS | B | 214 | −1.191 | 66.478 | 38.576 | 1.00 | 29.25 | | C |
| ANISOU | 4558 | CA | LYS | B | 214 | 4019 | 3359 | 3735 | 585 | −1123 | −1412 | C |
| ATOM | 4559 | C | LYS | B | 214 | −0.996 | 65.608 | 37.336 | 1.00 | 29.23 | | C |
| ANISOU | 4559 | C | LYS | B | 214 | 3800 | 3453 | 3851 | 458 | −992 | −1285 | C |
| ATOM | 4560 | O | LYS | B | 214 | −1.823 | 64.736 | 37.053 | 1.00 | 29.00 | | O |
| ANISOU | 4560 | O | LYS | B | 214 | 3745 | 3567 | 3707 | 458 | −814 | −1216 | O |
| ATOM | 4561 | CB | LYS | B | 214 | −0.488 | 65.868 | 39.787 | 1.00 | 33.40 | | C |
| ANISOU | 4561 | CB | LYS | B | 214 | 4706 | 3832 | 4152 | 634 | −1289 | −1483 | C |
| ATOM | 4562 | CG | LYS | B | 214 | −0.608 | 66.724 | 41.053 | 1.00 | 41.91 | | C |
| ANISOU | 4562 | CG | LYS | B | 214 | 6051 | 4790 | 5083 | 777 | −1444 | −1621 | C |
| ATOM | 4563 | CD | LYS | B | 214 | 0.329 | 66.244 | 42.153 | 1.00 | 49.60 | | C |
| ANISOU | 4563 | CD | LYS | B | 214 | 7191 | 5666 | 5987 | 814 | −1678 | −1697 | C |
| ATOM | 4564 | CE | LYS | B | 214 | 0.185 | 67.084 | 43.417 | 1.00 | 57.80 | | C |
| ANISOU | 4564 | CE | LYS | B | 214 | 8546 | 6571 | 6845 | 974 | −1845 | −1842 | C |
| ATOM | 4565 | NZ | LYS | B | 214 | 0.083 | 68.545 | 43.100 | 1.00 | 55.61 | | N |
| ANISOU | 4565 | NZ | LYS | B | 214 | 8254 | 6176 | 6700 | 985 | −1918 | −1899 | N |
| ATOM | 4566 | N | GLN | B | 215 | 0.090 | 65.841 | 36.598 | 1.00 | 28.18 | | N |
| ANISOU | 4566 | N | GLN | B | 215 | 3520 | 3229 | 3957 | 355 | −1076 | −1248 | N |
| ATOM | 4567 | CA | GLN | B | 215 | 0.325 | 65.116 | 35.360 | 1.00 | 28.26 | | C |
| ANISOU | 4567 | CA | GLN | B | 215 | 3355 | 3311 | 4074 | 251 | −941 | −1129 | C |
| ATOM | 4568 | C | GLN | B | 215 | 0.854 | 63.727 | 35.668 | 1.00 | 31.94 | | C |
| ANISOU | 4568 | C | GLN | B | 215 | 3813 | 3833 | 4490 | 225 | −945 | −1103 | C |
| ATOM | 4569 | O | GLN | B | 215 | 2.038 | 63.440 | 35.494 | 1.00 | 35.56 | | O |
| ANISOU | 4569 | O | GLN | B | 215 | 4177 | 4214 | 5120 | 161 | −1032 | −1080 | O |
| ATOM | 4570 | CB | GLN | B | 215 | 1.309 | 65.852 | 34.469 | 1.00 | 41.79 | | C |
| ANISOU | 4570 | CB | GLN | B | 215 | 4919 | 4898 | 6063 | 166 | −991 | −1083 | C |
| ATOM | 4571 | CG | GLN | B | 215 | 0.955 | 67.296 | 34.212 | 1.00 | 56.70 | | C |
| ANISOU | 4571 | CG | GLN | B | 215 | 6815 | 6700 | 8028 | 186 | −1019 | −1110 | C |
| ATOM | 4572 | CD | GLN | B | 215 | 1.891 | 67.936 | 33.207 | 1.00 | 65.15 | | C |
| ANISOU | 4572 | CD | GLN | B | 215 | 7724 | 7649 | 9381 | 96 | −1027 | −1034 | C |
| ATOM | 4573 | OE1 | GLN | B | 215 | 2.270 | 67.318 | 32.205 | 1.00 | 61.06 | | O |
| ANISOU | 4573 | OE1 | GLN | B | 215 | 7088 | 7169 | 8944 | 28 | −896 | −925 | O |
| ATOM | 4574 | NE2 | GLN | B | 215 | 2.283 | 69.176 | 33.478 | 1.00 | 69.55 | | N |
| ANISOU | 4574 | NE2 | GLN | B | 215 | 8285 | 8048 | 10092 | 102 | −1177 | −1085 | N |
| ATOM | 4575 | N | VAL | B | 216 | −0.025 | 62.864 | 36.150 | 1.00 | 30.88 | | N |
| ANISOU | 4575 | N | VAL | B | 216 | 3770 | 3825 | 4136 | 278 | −846 | −1101 | N |
| ATOM | 4576 | CA | VAL | B | 216 | 0.362 | 61.497 | 36.451 | 1.00 | 26.82 | | C |
| ANISOU | 4576 | CA | VAL | B | 216 | 3260 | 3370 | 3560 | 257 | −840 | −1072 | C |
| ATOM | 4577 | C | VAL | B | 216 | −0.792 | 60.598 | 36.069 | 1.00 | 23.69 | | C |
| ANISOU | 4577 | C | VAL | B | 216 | 2857 | 3129 | 3016 | 261 | −642 | −1001 | C |
| ATOM | 4578 | O | VAL | B | 216 | −1.927 | 60.863 | 36.463 | 1.00 | 35.65 | | O |
| ANISOU | 4578 | O | VAL | B | 216 | 4452 | 4699 | 4394 | 334 | −560 | −1015 | O |
| ATOM | 4579 | CB | VAL | B | 216 | 0.677 | 61.304 | 37.951 | 1.00 | 29.47 | | C |
| ANISOU | 4579 | CB | VAL | B | 216 | 3774 | 3656 | 3766 | 339 | −998 | −1163 | C |
| ATOM | 4580 | CG1 | VAL | B | 216 | 1.040 | 59.859 | 38.230 | 1.00 | 25.68 | | C |
| ANISOU | 4580 | CG1 | VAL | B | 216 | 3298 | 3237 | 3221 | 318 | −987 | −1123 | C |
| ATOM | 4581 | CG2 | VAL | B | 216 | 1.791 | 62.247 | 38.414 | 1.00 | 27.52 | | C |
| ANISOU | 4581 | CG2 | VAL | B | 216 | 3548 | 3228 | 3680 | 339 | −1246 | −1245 | C |
| ATOM | 4582 | N | PHE | B | 217 | −0.531 | 59.545 | 35.304 | 1.00 | 23.91 | | N |
| ANISOU | 4582 | N | PHE | B | 217 | 2787 | 3213 | 3084 | 188 | −566 | −921 | N |
| ATOM | 4583 | CA | PHE | B | 217 | −1.557 | 58.528 | 35.158 | 1.00 | 26.80 | | C |
| ANISOU | 4583 | CA | PHE | B | 217 | 3162 | 3706 | 3313 | 193 | −423 | −862 | C |
| ATOM | 4584 | C | PHE | B | 217 | −1.037 | 57.147 | 35.540 | 1.00 | 30.83 | | C |
| ANISOU | 4584 | C | PHE | B | 217 | 3688 | 4251 | 3774 | 172 | −438 | −838 | C |
| ATOM | 4585 | O | PHE | B | 217 | 0.126 | 56.799 | 35.324 | 1.00 | 35.90 | | O |
| ANISOU | 4585 | O | PHE | B | 217 | 4273 | 4836 | 4531 | 123 | −513 | −832 | O |
| ATOM | 4586 | CB | PHE | B | 217 | −2.168 | 58.528 | 33.746 | 1.00 | 20.97 | | C |
| ANISOU | 4586 | CB | PHE | B | 217 | 2321 | 3014 | 2633 | 136 | −301 | −782 | C |
| ATOM | 4587 | CG | PHE | B | 217 | −1.289 | 57.982 | 32.668 | 1.00 | 20.38 | | C |
| ANISOU | 4587 | CG | PHE | B | 217 | 2156 | 2915 | 2672 | 56 | −283 | −724 | C |
| ATOM | 4588 | CD1 | PHE | B | 217 | −1.388 | 56.640 | 32.288 | 1.00 | 19.71 | | C |
| ANISOU | 4588 | CD1 | PHE | B | 217 | 2057 | 2896 | 2535 | 21 | −218 | −666 | C |
| ATOM | 4589 | CD2 | PHE | B | 217 | −0.435 | 58.800 | 31.971 | 1.00 | 23.14 | | C |
| ANISOU | 4589 | CD2 | PHE | B | 217 | 2438 | 3170 | 3183 | 21 | −311 | −716 | C |
| ATOM | 4590 | CE1 | PHE | B | 217 | −0.616 | 56.120 | 31.276 | 1.00 | 19.33 | | C |
| ANISOU | 4590 | CE1 | PHE | B | 217 | 1951 | 2820 | 2575 | −34 | −181 | −613 | C |
| ATOM | 4591 | CE2 | PHE | B | 217 | 0.351 | 58.288 | 30.936 | 1.00 | 29.00 | | C |
| ANISOU | 4591 | CE2 | PHE | B | 217 | 3107 | 3884 | 4027 | −36 | −254 | −648 | C |
| ATOM | 4592 | CZ | PHE | B | 217 | 0.263 | 56.951 | 30.592 | 1.00 | 29.58 | | C |
| ANISOU | 4592 | CZ | PHE | B | 217 | 3187 | 4024 | 4027 | −58 | −187 | −601 | C |
| ATOM | 4593 | N | THR | B | 218 | −1.936 | 56.376 | 36.133 | 1.00 | 23.72 | | N |
| ANISOU | 4593 | N | THR | B | 218 | 2859 | 3438 | 2716 | 214 | −357 | −816 | N |
| ATOM | 4594 | CA | THR | B | 218 | −1.625 | 55.068 | 36.645 | 1.00 | 24.56 | | C |
| ANISOU | 4594 | CA | THR | B | 218 | 3004 | 3580 | 2750 | 208 | −365 | −791 | C |
| ATOM | 4595 | C | THR | B | 218 | −2.524 | 54.072 | 35.942 | 1.00 | 25.72 | | C |
| ANISOU | 4595 | C | THR | B | 218 | 3086 | 3821 | 2865 | 165 | −223 | −700 | C |
| ATOM | 4596 | O | THR | B | 218 | −3.716 | 54.324 | 35.768 | 1.00 | 20.70 | | O |
| ANISOU | 4596 | O | THR | B | 218 | 2437 | 3236 | 2192 | 187 | −122 | −669 | O |
| ATOM | 4597 | CB | THR | B | 218 | −1.827 | 54.987 | 38.167 | 1.00 | 30.59 | | C |
| ANISOU | 4597 | CB | THR | B | 218 | 3942 | 4339 | 3342 | 308 | −408 | −842 | C |
| ATOM | 4598 | OG1 | THR | B | 218 | −0.845 | 55.802 | 38.806 | 1.00 | 38.36 | | O |
| ANISOU | 4598 | OG1 | THR | B | 218 | 5002 | 5210 | 4365 | 343 | −591 | −934 | O |
| ATOM | 4599 | CG2 | THR | B | 218 | −1.653 | 53.565 | 38.671 | 1.00 | 30.98 | | C |
| ANISOU | 4599 | CG2 | THR | B | 218 | 4037 | 4430 | 3304 | 304 | −397 | −800 | C |
| ATOM | 4600 | N | ILE | B | 219 | −1.920 | 52.980 | 35.487 | 1.00 | 20.19 | | N |
| ANISOU | 4600 | N | ILE | B | 219 | 2338 | 3129 | 2204 | 105 | −229 | −659 | N |
| ATOM | 4601 | CA | ILE | B | 219 | −2.640 | 51.840 | 34.961 | 1.00 | 26.30 | | C |
| ANISOU | 4601 | CA | ILE | B | 219 | 3075 | 3974 | 2944 | 65 | −133 | −580 | C |
| ATOM | 4602 | C | ILE | B | 219 | −2.559 | 50.680 | 35.959 | 1.00 | 28.96 | | C |
| ANISOU | 4602 | C | ILE | B | 219 | 3486 | 4339 | 3178 | 88 | −139 | −563 | C |
| ATOM | 4603 | O | ILE | B | 219 | −1.484 | 50.346 | 36.460 | 1.00 | 23.13 | | O |
| ANISOU | 4603 | O | ILE | B | 219 | 2786 | 3556 | 2447 | 92 | −236 | −595 | O |
| ATOM | 4604 | CB | ILE | B | 219 | −2.090 | 51.407 | 33.617 | 1.00 | 22.49 | | C |
| ANISOU | 4604 | CB | ILE | B | 219 | 2509 | 3470 | 2565 | −10 | −123 | −542 | C |
| ATOM | 4605 | CG1 | ILE | B | 219 | −2.346 | 52.516 | 32.596 | 1.00 | 23.30 | | C |
| ANISOU | 4605 | CG1 | ILE | B | 219 | 2562 | 3547 | 2745 | −25 | −98 | −542 | C |
| ATOM | 4606 | CG2 | ILE | B | 219 | −2.737 | 50.090 | 33.186 | 1.00 | 18.36 | | C |
| ANISOU | 4606 | CG2 | ILE | B | 219 | 1977 | 3000 | 2000 | −47 | −62 | −472 | C |
| ATOM | 4607 | CD1 | ILE | B | 219 | −1.803 | 52.222 | 31.207 | 1.00 | 18.08 | | C |
| ANISOU | 4607 | CD1 | ILE | B | 219 | 1856 | 2851 | 2164 | −79 | −68 | −501 | C |
| ATOM | 4608 | N | CYS | B | 220 | −3.702 | 50.084 | 36.270 | 1.00 | 28.26 | | N |
| ANISOU | 4608 | N | CYS | B | 220 | 3415 | 4314 | 3011 | 105 | −39 | −504 | N |
| ATOM | 4609 | CA | CYS | B | 220 | −3.734 | 49.054 | 37.297 | 1.00 | 28.61 | | C |
| ANISOU | 4609 | CA | CYS | B | 220 | 3544 | 4380 | 2948 | 137 | −25 | −475 | C |
| ATOM | 4610 | C | CYS | B | 220 | −4.578 | 47.881 | 36.813 | 1.00 | 26.62 | | C |
| ANISOU | 4610 | C | CYS | B | 220 | 3226 | 4176 | 2712 | 84 | 66 | −377 | C |
| ATOM | 4611 | O | CYS | B | 220 | −5.787 | 47.870 | 37.028 | 1.00 | 30.61 | | O |
| ANISOU | 4611 | O | CYS | B | 220 | 3711 | 4718 | 3199 | 107 | 174 | −319 | O |
| ATOM | 4612 | CB | CYS | B | 220 | −4.279 | 49.632 | 38.619 | 1.00 | 21.85 | | C |
| ANISOU | 4612 | CB | CYS | B | 220 | 2819 | 3529 | 1955 | 247 | 17 | −500 | C |
| ATOM | 4613 | SG | CYS | B | 220 | −4.019 | 48.557 | 40.064 | 1.00 | 67.31 | | S |
| ANISOU | 4613 | SG | CYS | B | 220 | 8745 | 9286 | 7543 | 314 | 11 | −479 | S |
| ATOM | 4614 | N | ILE | B | 221 | −3.951 | 46.883 | 36.189 | 1.00 | 23.08 | | N |
| ANISOU | 4614 | N | ILE | B | 221 | 2741 | 3715 | 2313 | 18 | 21 | −355 | N |
| ATOM | 4615 | CA | ILE | B | 221 | −4.730 | 45.799 | 35.602 | 1.00 | 32.09 | | C |
| ANISOU | 4615 | CA | ILE | B | 221 | 3824 | 4881 | 3487 | −39 | 77 | −270 | C |
| ATOM | 4616 | C | ILE | B | 221 | −4.804 | 44.535 | 36.497 | 1.00 | 29.56 | | C |
| ANISOU | 4616 | C | ILE | B | 221 | 3560 | 4575 | 3097 | −29 | 101 | −214 | C |
| ATOM | 4617 | O | ILE | B | 221 | −3.853 | 44.175 | 37.204 | 1.00 | 26.51 | | O |
| ANISOU | 4617 | O | ILE | B | 221 | 3254 | 4169 | 2650 | −2 | 39 | −246 | O |
| ATOM | 4618 | CB | ILE | B | 221 | −4.196 | 45.397 | 34.187 | 1.00 | 50.95 | | C |
| ANISOU | 4618 | CB | ILE | B | 221 | 6157 | 7237 | 5965 | −112 | 27 | −272 | C |
| ATOM | 4619 | CG1 | ILE | B | 221 | −2.856 | 44.719 | 34.284 | 1.00 | 47.47 | | C |
| ANISOU | 4619 | CG1 | ILE | B | 221 | 5750 | 6760 | 5527 | −120 | −38 | −299 | C |
| ATOM | 4620 | CG2 | ILE | B | 221 | −4.114 | 46.588 | 33.192 | 1.00 | 18.16 | | C |
| ANISOU | 4620 | CG2 | ILE | B | 221 | 1963 | 3061 | 1878 | −121 | 15 | −311 | C |
| ATOM | 4621 | CD1 | ILE | B | 221 | −2.690 | 43.681 | 33.220 | 1.00 | 46.48 | | C |
| ANISOU | 4621 | CD1 | ILE | B | 221 | 5605 | 6609 | 5447 | −176 | −45 | −265 | C |
| ATOM | 4622 | N | SER | B | 222 | −5.975 | 43.902 | 36.472 | 1.00 | 31.32 | | N |
| ANISOU | 4622 | N | SER | B | 222 | 3735 | 4822 | 3344 | −51 | 187 | −122 | N |
| ATOM | 4623 | CA | SER | B | 222 | −6.232 | 42.596 | 37.090 | 1.00 | 28.26 | | C |
| ANISOU | 4623 | CA | SER | B | 222 | 3375 | 4438 | 2924 | −59 | 226 | −41 | C |
| ATOM | 4624 | C | SER | B | 222 | −6.275 | 41.501 | 36.020 | 1.00 | 31.94 | | C |
| ANISOU | 4624 | C | SER | B | 222 | 3772 | 4876 | 3487 | −152 | 174 | 1 | C |
| ATOM | 4625 | O | SER | B | 222 | −6.044 | 41.798 | 34.843 | 1.00 | 19.59 | | O |
| ANISOU | 4625 | O | SER | B | 222 | 2165 | 3289 | 1989 | −195 | 112 | −39 | O |
| ATOM | 4626 | CB | SER | B | 222 | −7.556 | 42.629 | 37.849 | 1.00 | 31.69 | | C |
| ANISOU | 4626 | CB | SER | B | 222 | 3791 | 4899 | 3349 | −15 | 373 | 51 | C |
| ATOM | 4627 | OG | SER | B | 222 | −7.500 | 43.560 | 38.915 | 1.00 | 41.51 | | O |
| ANISOU | 4627 | OG | SER | B | 222 | 5141 | 6159 | 4471 | 91 | 430 | 9 | O |
| ATOM | 4628 | N | GLU | B | 223 | −6.562 | 40.249 | 36.415 | 1.00 | 29.61 | | N |
| ANISOU | 4628 | N | GLU | B | 223 | 3485 | 4572 | 3193 | −175 | 198 | 82 | N |
| ATOM | 4629 | CA | GLU | B | 223 | −6.781 | 39.178 | 35.433 | 1.00 | 27.47 | | C |
| ANISOU | 4629 | CA | GLU | B | 223 | 3159 | 4258 | 3019 | −260 | 140 | 125 | C |
| ATOM | 4630 | C | GLU | B | 223 | −7.909 | 39.589 | 34.523 | 1.00 | 27.43 | | C |
| ANISOU | 4630 | C | GLU | B | 223 | 3050 | 4240 | 3133 | −303 | 141 | 159 | C |
| ATOM | 4631 | O | GLU | B | 223 | −7.879 | 39.336 | 33.325 | 1.00 | 33.42 | | O |
| ANISOU | 4631 | O | GLU | B | 223 | 3791 | 4953 | 3953 | −358 | 49 | 140 | O |
| ATOM | 4632 | CB | GLU | B | 223 | −7.169 | 37.832 | 36.065 | 1.00 | 28.19 | | C |
| ANISOU | 4632 | CB | GLU | B | 223 | 3258 | 4331 | 3121 | −282 | 174 | 226 | C |
| ATOM | 4633 | CG | GLU | B | 223 | −6.063 | 36.953 | 36.587 | 1.00 | 38.37 | | C |
| ANISOU | 4633 | CG | GLU | B | 223 | 4646 | 5605 | 4329 | −268 | 126 | 207 | C |
| ATOM | 4634 | CD | GLU | B | 223 | −4.840 | 36.819 | 35.690 | 1.00 | 37.60 | | C |
| ANISOU | 4634 | CD | GLU | B | 223 | 4575 | 5473 | 4237 | −288 | 13 | 116 | C |
| ATOM | 4635 | OE1 | GLU | B | 223 | −4.965 | 36.596 | 34.455 | 1.00 | 27.43 | | O |
| ANISOU | 4635 | OE1 | GLU | B | 223 | 3250 | 4147 | 3026 | −341 | −40 | 103 | O |
| ATOM | 4636 | OE2 | GLU | B | 223 | −3.732 | 36.919 | 36.271 | 1.00 | 37.34 | | O |
| ANISOU | 4636 | OE2 | GLU | B | 223 | 4612 | 5442 | 4135 | −241 | −23 | 61 | O |
| ATOM | 4637 | N | ASN | B | 224 | −8.925 | 40.189 | 35.138 | 1.00 | 28.95 | | N |
| ANISOU | 4637 | N | ASN | B | 224 | 3184 | 4462 | 3355 | −268 | 246 | 215 | N |
| ATOM | 4638 | CA | ASN | B | 224 | −10.119 | 40.679 | 34.453 | 1.00 | 26.59 | | C |
| ANISOU | 4638 | CA | ASN | B | 224 | 2764 | 4146 | 3195 | −298 | 252 | 261 | C |
| ATOM | 4639 | C | ASN | B | 224 | −10.322 | 42.153 | 34.693 | 1.00 | 28.05 | | C |
| ANISOU | 4639 | C | ASN | B | 224 | 2938 | 4369 | 3349 | −230 | 316 | 214 | C |
| ATOM | 4640 | O | ASN | B | 224 | −10.597 | 42.568 | 35.822 | 1.00 | 33.77 | | O |
| ANISOU | 4640 | O | ASN | B | 224 | 3688 | 5131 | 4013 | −153 | 444 | 238 | O |
| ATOM | 4641 | CB | ASN | B | 224 | −11.370 | 39.929 | 34.922 | 1.00 | 28.11 | | C |
| ANISOU | 4641 | CB | ASN | B | 224 | 2849 | 4315 | 3516 | −321 | 336 | 404 | C |
| ATOM | 4642 | CG | ASN | B | 224 | −11.250 | 38.443 | 34.736 | 1.00 | 36.99 | | C |
| ANISOU | 4642 | CG | ASN | B | 224 | 3980 | 5387 | 4689 | −392 | 267 | 459 | C |
| ATOM | 4643 | OD1 | ASN | B | 224 | −11.176 | 37.954 | 33.610 | 1.00 | 40.34 | | O |
| ANISOU | 4643 | OD1 | ASN | B | 224 | 4396 | 5751 | 5179 | −462 | 120 | 435 | O |
| ATOM | 4644 | ND2 | ASN | B | 224 | −11.223 | 37.713 | 35.840 | 1.00 | 36.39 | | N |
| ANISOU | 4644 | ND2 | ASN | B | 224 | 3939 | 5324 | 4565 | −365 | 369 | 532 | N |
| ATOM | 4645 | N | GLY | B | 225 | −10.193 | 42.938 | 33.629 | 1.00 | 28.50 | | N |
| ANISOU | 4645 | N | GLY | B | 225 | 2978 | 4410 | 3439 | −251 | 230 | 148 | N |
| ATOM | 4646 | CA | GLY | B | 225 | −10.382 | 44.372 | 33.707 | 1.00 | 23.52 | | C |
| ANISOU | 4646 | CA | GLY | B | 225 | 2336 | 3805 | 2797 | −193 | 272 | 100 | C |
| ATOM | 4647 | C | GLY | B | 225 | −9.411 | 45.056 | 34.648 | 1.00 | 29.99 | | C |
| ANISOU | 4647 | C | GLY | B | 225 | 3266 | 4660 | 3469 | −115 | 312 | 19 | C |
| ATOM | 4648 | O | GLY | B | 225 | −8.421 | 44.475 | 35.083 | 1.00 | 35.22 | | O |
| ANISOU | 4648 | O | GLY | B | 225 | 4015 | 5324 | 4043 | −111 | 280 | −13 | O |
| ATOM | 4649 | N | GLY | B | 226 | −9.694 | 46.302 | 34.982 | 1.00 | 35.33 | | N |
| ANISOU | 4649 | N | GLY | B | 226 | 3942 | 5352 | 4128 | −49 | 365 | −16 | N |
| ATOM | 4650 | CA | GLY | B | 226 | −8.804 | 47.030 | 35.850 | 1.00 | 32.30 | | C |
| ANISOU | 4650 | CA | GLY | B | 226 | 3677 | 4981 | 3616 | 27 | 368 | −103 | C |
| ATOM | 4651 | C | GLY | B | 226 | −9.203 | 48.473 | 35.953 | 1.00 | 31.58 | | C |
| ANISOU | 4651 | C | GLY | B | 226 | 3580 | 4891 | 3530 | 91 | 405 | −147 | C |
| ATOM | 4652 | O | GLY | B | 226 | −10.391 | 48.801 | 35.926 | 1.00 | 31.43 | | O |
| ANISOU | 4652 | O | GLY | B | 226 | 3477 | 4879 | 3587 | 112 | 494 | −85 | O |
| ATOM | 4653 | N | GLU | B | 227 | −8.212 | 49.343 | 36.096 | 1.00 | 31.15 | | N |
| ANISOU | 4653 | N | GLU | B | 227 | 3605 | 4817 | 3412 | 123 | 333 | −249 | N |
| ATOM | 4654 | CA | GLU | B | 227 | −8.516 | 50.739 | 36.296 | 1.00 | 25.47 | | C |
| ANISOU | 4654 | CA | GLU | B | 227 | 2901 | 4087 | 2688 | 192 | 358 | −300 | C |
| ATOM | 4655 | C | GLU | B | 227 | −7.442 | 51.662 | 35.772 | 1.00 | 25.79 | | C |
| ANISOU | 4655 | C | GLU | B | 227 | 2967 | 4086 | 2748 | 175 | 239 | −397 | C |
| ATOM | 4656 | O | GLU | B | 227 | −6.250 | 51.387 | 35.886 | 1.00 | 26.26 | | O |
| ANISOU | 4656 | O | GLU | B | 227 | 3078 | 4119 | 2779 | 155 | 149 | −444 | O |
| ATOM | 4657 | CB | GLU | B | 227 | −8.760 | 50.994 | 37.773 | 1.00 | 28.72 | | C |
| ANISOU | 4657 | CB | GLU | B | 227 | 3437 | 4507 | 2967 | 311 | 450 | −311 | C |
| ATOM | 4658 | CG | GLU | B | 227 | −9.285 | 52.383 | 38.083 | 1.00 | 35.09 | | C |
| ANISOU | 4658 | CG | GLU | B | 227 | 4273 | 5298 | 3762 | 402 | 502 | −355 | C |
| ATOM | 4659 | CD | GLU | B | 227 | −9.719 | 52.496 | 39.528 | 1.00 | 50.30 | | C |
| ANISOU | 4659 | CD | GLU | B | 227 | 6345 | 7227 | 5539 | 539 | 631 | −348 | C |
| ATOM | 4660 | OE1 | GLU | B | 227 | −10.888 | 52.153 | 39.817 | 1.00 | 54.71 | | O |
| ANISOU | 4660 | OE1 | GLU | B | 227 | 6847 | 7813 | 6128 | 578 | 805 | −244 | O |
| ATOM | 4661 | OE2 | GLU | B | 227 | −8.886 | 52.894 | 40.375 | 1.00 | 48.12 | | O |
| ANISOU | 4661 | OE2 | GLU | B | 227 | 6249 | 6914 | 5120 | 611 | 556 | −440 | O |
| ATOM | 4662 | N | LEU | B | 228 | −7.894 | 52.765 | 35.186 | 1.00 | 30.97 | | N |
| ANISOU | 4662 | N | LEU | B | 228 | 3570 | 4725 | 3472 | 184 | 242 | −415 | N |
| ATOM | 4663 | CA | LEU | B | 228 | −7.033 | 53.861 | 34.790 | 1.00 | 23.97 | | C |
| ANISOU | 4663 | CA | LEU | B | 228 | 2703 | 3787 | 2618 | 181 | 151 | −496 | C |
| ATOM | 4664 | C | LEU | B | 228 | −7.263 | 55.060 | 35.707 | 1.00 | 30.88 | | C |
| ANISOU | 4664 | C | LEU | B | 228 | 3655 | 4638 | 3439 | 283 | 169 | −559 | C |
| ATOM | 4665 | O | LEU | B | 228 | −8.388 | 55.527 | 35.896 | 1.00 | 34.87 | | O |
| ANISOU | 4665 | O | LEU | B | 228 | 4138 | 5162 | 3950 | 339 | 264 | −530 | O |
| ATOM | 4666 | CB | LEU | B | 228 | −7.289 | 54.231 | 33.338 | 1.00 | 21.70 | | C |
| ANISOU | 4666 | CB | LEU | B | 228 | 2322 | 3482 | 2443 | 116 | 130 | −468 | C |
| ATOM | 4667 | CG | LEU | B | 228 | −6.601 | 55.506 | 32.870 | 1.00 | 25.29 | | C |
| ANISOU | 4667 | CG | LEU | B | 228 | 2783 | 3876 | 2951 | 119 | 66 | −531 | C |
| ATOM | 4668 | CD1 | LEU | B | 228 | −5.097 | 55.271 | 32.824 | 1.00 | 23.72 | | C |
| ANISOU | 4668 | CD1 | LEU | B | 228 | 2611 | 3632 | 2768 | 83 | −11 | −570 | C |
| ATOM | 4669 | CD2 | LEU | B | 228 | −7.128 | 55.930 | 31.518 | 1.00 | 23.44 | | C |
| ANISOU | 4669 | CD2 | LEU | B | 228 | 2481 | 3623 | 2801 | 76 | 66 | −490 | C |
| ATOM | 4670 | N | ILE | B | 229 | −6.185 | 55.559 | 36.282 | 1.00 | 31.19 | | N |
| ANISOU | 4670 | N | ILE | B | 229 | 3788 | 4624 | 3439 | 312 | 67 | −645 | N |
| ATOM | 4671 | CA | ILE | B | 229 | −6.285 | 56.679 | 37.185 | 1.00 | 26.47 | | C |
| ANISOU | 4671 | CA | ILE | B | 229 | 3299 | 3982 | 2775 | 416 | 53 | −721 | C |
| ATOM | 4672 | C | ILE | B | 229 | −5.561 | 57.881 | 36.640 | 1.00 | 23.71 | | C |
| ANISOU | 4672 | C | ILE | B | 229 | 2927 | 3554 | 2529 | 393 | −62 | −789 | C |
| ATOM | 4673 | O | ILE | B | 229 | −4.396 | 57.785 | 36.267 | 1.00 | 29.50 | | O |
| ANISOU | 4673 | O | ILE | B | 229 | 3632 | 4238 | 3338 | 328 | −172 | −812 | O |
| ATOM | 4674 | CB | ILE | B | 229 | −5.706 | 56.323 | 38.547 | 1.00 | 27.52 | | C |
| ANISOU | 4674 | CB | ILE | B | 229 | 3604 | 4092 | 2761 | 491 | 0 | −773 | C |
| ATOM | 4675 | CG1 | ILE | B | 229 | −6.359 | 55.054 | 39.070 | 1.00 | 26.56 | | C |
| ANISOU | 4675 | CG1 | ILE | B | 229 | 3507 | 4043 | 2542 | 509 | 126 | −689 | C |
| ATOM | 4676 | CG2 | ILE | B | 229 | −5.900 | 57.454 | 39.528 | 1.00 | 25.13 | | C |
| ANISOU | 4676 | CG2 | ILE | B | 229 | 3458 | 3731 | 2358 | 618 | −16 | −857 | C |
| ATOM | 4677 | CD1 | ILE | B | 229 | −5.671 | 54.532 | 40.320 | 1.00 | 36.22 | | C |
| ANISOU | 4677 | CD1 | ILE | B | 229 | 4914 | 5238 | 3610 | 576 | 60 | −730 | C |
| ATOM | 4678 | N | ALA | B | 230 | −6.247 | 59.016 | 36.605 | 1.00 | 23.13 | | N |
| ANISOU | 4678 | N | ALA | B | 230 | 2858 | 3457 | 2473 | 449 | −27 | −814 | N |
| ATOM | 4679 | CA | ALA | B | 230 | −5.612 | 60.282 | 36.259 | 1.00 | 23.28 | | C |
| ANISOU | 4679 | CA | ALA | B | 230 | 2874 | 3385 | 2587 | 441 | −137 | −881 | C |
| ATOM | 4680 | C | ALA | B | 230 | −5.475 | 61.158 | 37.502 | 1.00 | 25.23 | | C |
| ANISOU | 4680 | C | ALA | B | 230 | 3288 | 3560 | 2738 | 557 | −205 | −984 | C |
| ATOM | 4681 | O | ALA | B | 230 | −6.424 | 61.307 | 38.268 | 1.00 | 29.30 | | O |
| ANISOU | 4681 | O | ALA | B | 230 | 3896 | 4103 | 3133 | 665 | −101 | −989 | O |
| ATOM | 4682 | CB | ALA | B | 230 | −6.410 | 61.005 | 35.175 | 1.00 | 22.86 | | C |
| ANISOU | 4682 | CB | ALA | B | 230 | 2711 | 3339 | 2637 | 416 | −75 | −837 | C |
| ATOM | 4683 | N | GLY | B | 231 | −4.294 | 61.735 | 37.701 | 1.00 | 33.43 | | N |
| ANISOU | 4683 | N | GLY | B | 231 | 4371 | 4493 | 3838 | 542 | −382 | −1061 | N |
| ATOM | 4684 | CA | GLY | B | 231 | −4.059 | 62.639 | 38.818 | 1.00 | 26.66 | | C |
| ANISOU | 4684 | CA | GLY | B | 231 | 3694 | 3536 | 2898 | 650 | −496 | −1173 | C |
| ATOM | 4685 | C | GLY | B | 231 | −3.086 | 62.091 | 39.854 | 1.00 | 35.27 | | C |
| ANISOU | 4685 | C | GLY | B | 231 | 4929 | 4570 | 3904 | 677 | −651 | −1234 | C |
| ATOM | 4686 | O | GLY | B | 231 | −2.646 | 62.823 | 40.736 | 1.00 | 33.04 | | O |
| ANISOU | 4686 | O | GLY | B | 231 | 4813 | 4174 | 3568 | 757 | −808 | −1338 | O |
| ATOM | 4687 | N | GLY | B | 232 | −2.747 | 60.804 | 39.742 | 1.00 | 35.02 | | N |
| ANISOU | 4687 | N | GLY | B | 232 | 4841 | 4604 | 3860 | 615 | −625 | −1171 | N |
| ATOM | 4688 | CA | GLY | B | 232 | −1.865 | 60.138 | 40.689 | 1.00 | 33.03 | | C |
| ANISOU | 4688 | CA | GLY | B | 232 | 4718 | 4305 | 3529 | 639 | −771 | −1214 | C |
| ATOM | 4689 | C | GLY | B | 232 | −2.031 | 58.618 | 40.680 | 1.00 | 39.30 | | C |
| ANISOU | 4689 | C | GLY | B | 232 | 5477 | 5206 | 4248 | 604 | −661 | −1127 | C |
| ATOM | 4690 | O | GLY | B | 232 | −2.483 | 58.031 | 39.690 | 1.00 | 31.03 | | O |
| ANISOU | 4690 | O | GLY | B | 232 | 4264 | 4252 | 3275 | 522 | −519 | −1034 | O |
| ATOM | 4691 | N | TYR | B | 233 | −1.631 | 57.973 | 41.770 | 1.00 | 34.48 | | N |
| ANISOU | 4691 | N | TYR | B | 233 | 5036 | 4571 | 3494 | 665 | −746 | −1158 | N |
| ATOM | 4692 | CA | TYR | B | 233 | −1.965 | 56.570 | 41.974 | 1.00 | 31.91 | | C |
| ANISOU | 4692 | CA | TYR | B | 233 | 4718 | 4343 | 3062 | 658 | −627 | −1075 | C |
| ATOM | 4693 | C | TYR | B | 233 | −2.745 | 56.477 | 43.266 | 1.00 | 33.40 | | C |
| ANISOU | 4693 | C | TYR | B | 233 | 5154 | 4545 | 2991 | 809 | −540 | −1091 | C |
| ATOM | 4694 | O | TYR | B | 233 | −2.784 | 57.434 | 44.039 | 1.00 | 35.77 | | O |
| ANISOU | 4694 | O | TYR | B | 233 | 5641 | 4763 | 3186 | 921 | −614 | −1182 | O |
| ATOM | 4695 | CB | TYR | B | 233 | −0.710 | 55.680 | 42.025 | 1.00 | 35.52 | | C |
| ANISOU | 4695 | CB | TYR | B | 233 | 5144 | 4757 | 3592 | 589 | −788 | −1074 | C |
| ATOM | 4696 | CG | TYR | B | 233 | 0.231 | 56.021 | 43.162 | 1.00 | 42.24 | | C |
| ANISOU | 4696 | CG | TYR | B | 233 | 6193 | 5475 | 4380 | 663 | −1040 | −1178 | C |
| ATOM | 4697 | CD1 | TYR | B | 233 | 1.165 | 57.047 | 43.026 | 1.00 | 29.37 | | C |
| ANISOU | 4697 | CD1 | TYR | B | 233 | 4527 | 3710 | 2922 | 636 | −1256 | −1259 | C |
| ATOM | 4698 | CD2 | TYR | B | 233 | 0.191 | 55.320 | 44.367 | 1.00 | 29.99 | | C |
| ANISOU | 4698 | CD2 | TYR | B | 233 | 4874 | 3917 | 2605 | 760 | −1074 | −1190 | C |
| ATOM | 4699 | CE1 | TYR | B | 233 | 2.019 | 57.379 | 44.059 | 1.00 | 31.15 | | C |
| ANISOU | 4699 | CE1 | TYR | B | 233 | 4936 | 3790 | 3110 | 702 | −1527 | −1359 | C |
| ATOM | 4700 | CE2 | TYR | B | 233 | 1.045 | 55.643 | 45.403 | 1.00 | 37.31 | | C |
| ANISOU | 4700 | CE2 | TYR | B | 233 | 6011 | 4705 | 3462 | 836 | −1337 | −1291 | C |
| ATOM | 4701 | CZ | TYR | B | 233 | 1.962 | 56.683 | 45.242 | 1.00 | 39.36 | | C |
| ANISOU | 4701 | CZ | TYR | B | 233 | 6224 | 4822 | 3909 | 804 | −1579 | −1380 | C |
| ATOM | 4702 | OH | TYR | B | 233 | 2.822 | 57.039 | 46.266 | 1.00 | 41.88 | | O |
| ANISOU | 4702 | OH | TYR | B | 233 | 6720 | 4979 | 4213 | 864 | −1843 | −1449 | O |
| ATOM | 4703 | N | ASP | B | 234 | −3.368 | 55.333 | 43.505 | 1.00 | 28.58 | | N |
| ANISOU | 4703 | N | ASP | B | 234 | 4556 | 4027 | 2276 | 821 | −377 | −998 | N |
| ATOM | 4704 | CA | ASP | B | 234 | −4.098 | 55.130 | 44.743 | 1.00 | 33.52 | | C |
| ANISOU | 4704 | CA | ASP | B | 234 | 5423 | 4663 | 2652 | 973 | −256 | −988 | C |
| ATOM | 4705 | C | ASP | B | 234 | −3.305 | 54.258 | 45.703 | 1.00 | 34.64 | | C |
| ANISOU | 4705 | C | ASP | B | 234 | 5754 | 4759 | 2648 | 1012 | −387 | −1005 | C |
| ATOM | 4706 | O | ASP | B | 234 | −3.088 | 53.071 | 45.438 | 1.00 | 35.31 | | O |
| ANISOU | 4706 | O | ASP | B | 234 | 5742 | 4898 | 2775 | 932 | −363 | −927 | O |
| ATOM | 4707 | CB | ASP | B | 234 | −5.467 | 54.520 | 44.457 | 1.00 | 40.33 | | C |
| ANISOU | 4707 | CB | ASP | B | 234 | 6175 | 5642 | 3506 | 974 | 38 | −855 | C |
| ATOM | 4708 | CG | ASP | B | 234 | −6.397 | 54.593 | 45.646 | 1.00 | 46.12 | | C |
| ANISOU | 4708 | CG | ASP | B | 234 | 7136 | 6377 | 4011 | 1150 | 225 | −830 | C |
| ATOM | 4709 | OD1 | ASP | B | 234 | −5.897 | 54.616 | 46.788 | 1.00 | 53.07 | | O |
| ANISOU | 4709 | OD1 | ASP | B | 234 | 8298 | 7184 | 4683 | 1266 | 130 | −896 | O |
| ATOM | 4710 | OD2 | ASP | B | 234 | −7.629 | 54.653 | 45.440 | 1.00 | 47.72 | | O |
| ANISOU | 4710 | OD2 | ASP | B | 234 | 7243 | 6643 | 4247 | 1181 | 468 | −740 | O |
| ATOM | 4711 | N | PRO | B | 235 | −2.874 | 54.850 | 46.830 | 1.00 | 34.42 | | N |
| ANISOU | 4711 | N | PRO | B | 235 | 6013 | 4622 | 2445 | 1144 | −541 | −1111 | N |
| ATOM | 4712 | CA | PRO | B | 235 | −2.099 | 54.139 | 47.852 | 1.00 | 41.55 | | C |
| ANISOU | 4712 | CA | PRO | B | 235 | 7145 | 5456 | 3187 | 1203 | −706 | −1140 | C |
| ATOM | 4713 | C | PRO | B | 235 | −2.900 | 52.988 | 48.473 | 1.00 | 44.07 | | C |
| ANISOU | 4713 | C | PRO | B | 235 | 7559 | 5856 | 3328 | 1262 | −467 | −1014 | C |
| ATOM | 4714 | O | PRO | B | 235 | −2.325 | 51.987 | 48.898 | 1.00 | 47.77 | | O |
| ANISOU | 4714 | O | PRO | B | 235 | 8085 | 6309 | 3758 | 1240 | −550 | −976 | O |
| ATOM | 4715 | CB | PRO | B | 235 | −1.799 | 55.226 | 48.898 | 1.00 | 37.64 | | C |
| ANISOU | 4715 | CB | PRO | B | 235 | 6871 | 4807 | 2622 | 1307 | −853 | −1217 | C |
| ATOM | 4716 | CG | PRO | B | 235 | −2.057 | 56.512 | 48.218 | 1.00 | 37.87 | | C |
| ANISOU | 4716 | CG | PRO | B | 235 | 6805 | 4821 | 2763 | 1298 | −859 | −1290 | C |
| ATOM | 4717 | CD | PRO | B | 235 | −3.148 | 56.239 | 47.228 | 1.00 | 34.28 | | C |
| ANISOU | 4717 | CD | PRO | B | 235 | 6146 | 4524 | 2356 | 1256 | −576 | −1211 | C |
| ATOM | 4718 | N | ALA | B | 236 | −4.221 | 53.126 | 48.482 | 1.00 | 40.81 | | N |
| ANISOU | 4718 | N | ALA | B | 236 | 7139 | 5523 | 2843 | 1331 | −170 | −939 | N |
| ATOM | 4719 | CA | ALA | B | 236 | −5.091 | 52.132 | 49.088 | 1.00 | 44.27 | | C |
| ANISOU | 4719 | CA | ALA | B | 236 | 7640 | 6022 | 3157 | 1386 | 86 | −799 | C |
| ATOM | 4720 | C | ALA | B | 236 | −5.030 | 50.772 | 48.373 | 1.00 | 45.57 | | C |
| ANISOU | 4720 | C | ALA | B | 236 | 7605 | 6283 | 3427 | 1257 | 140 | −696 | C |
| ATOM | 4721 | O | ALA | B | 236 | −5.343 | 49.753 | 48.973 | 1.00 | 48.59 | | O |
| ANISOU | 4721 | O | ALA | B | 236 | 8085 | 6691 | 3684 | 1299 | 266 | −598 | O |
| ATOM | 4722 | CB | ALA | B | 236 | −6.528 | 52.650 | 49.120 | 1.00 | 36.61 | | C |
| ANISOU | 4722 | CB | ALA | B | 236 | 6635 | 5102 | 2172 | 1468 | 395 | −724 | C |
| ATOM | 4723 | N | TYR | B | 237 | −4.642 | 50.764 | 47.098 | 1.00 | 40.50 | | N |
| ANISOU | 4723 | N | TYR | B | 237 | 6666 | 5675 | 3047 | 1087 | 49 | −700 | N |
| ATOM | 4724 | CA | TYR | B | 237 | −4.530 | 49.524 | 46.332 | 1.00 | 30.70 | | C |
| ANISOU | 4724 | CA | TYR | B | 237 | 5213 | 4500 | 1952 | 946 | 78 | −603 | C |
| ATOM | 4725 | C | TYR | B | 237 | −3.253 | 48.776 | 46.653 | 1.00 | 35.84 | | C |
| ANISOU | 4725 | C | TYR | B | 237 | 5942 | 5094 | 2581 | 911 | −150 | −641 | C |
| ATOM | 4726 | O | TYR | B | 237 | −3.107 | 47.616 | 46.295 | 1.00 | 34.69 | | O |
| ANISOU | 4726 | O | TYR | B | 237 | 5687 | 4989 | 2505 | 825 | −128 | −561 | O |
| ATOM | 4727 | CB | TYR | B | 237 | −4.534 | 49.791 | 44.832 | 1.00 | 33.66 | | C |
| ANISOU | 4727 | CB | TYR | B | 237 | 5282 | 4917 | 2590 | 795 | 63 | −597 | C |
| ATOM | 4728 | CG | TYR | B | 237 | −5.765 | 50.468 | 44.288 | 1.00 | 36.87 | | C |
| ANISOU | 4728 | CG | TYR | B | 237 | 5561 | 5375 | 3071 | 802 | 256 | −552 | C |
| ATOM | 4729 | CD1 | TYR | B | 237 | −6.923 | 50.576 | 45.045 | 1.00 | 32.42 | | C |
| ANISOU | 4729 | CD1 | TYR | B | 237 | 5100 | 4835 | 2381 | 924 | 482 | −487 | C |
| ATOM | 4730 | CD2 | TYR | B | 237 | −5.775 | 50.976 | 42.990 | 1.00 | 36.49 | | C |
| ANISOU | 4730 | CD2 | TYR | B | 237 | 5288 | 5345 | 3230 | 692 | 220 | −565 | C |
| ATOM | 4731 | CE1 | TYR | B | 237 | −8.048 | 51.186 | 44.531 | 1.00 | 34.35 | | C |
| ANISOU | 4731 | CE1 | TYR | B | 237 | 5203 | 5117 | 2729 | 931 | 651 | −439 | C |
| ATOM | 4732 | CE2 | TYR | B | 237 | −6.885 | 51.575 | 42.473 | 1.00 | 26.83 | | C |
| ANISOU | 4732 | CE2 | TYR | B | 237 | 3947 | 4159 | 2087 | 698 | 371 | −523 | C |
| ATOM | 4733 | CZ | TYR | B | 237 | −8.023 | 51.685 | 43.244 | 1.00 | 32.91 | | C |
| ANISOU | 4733 | CZ | TYR | B | 237 | 4799 | 4951 | 2756 | 815 | 579 | −461 | C |
| ATOM | 4734 | OH | TYR | B | 237 | −9.145 | 52.292 | 42.724 | 1.00 | 34.04 | | O |
| ANISOU | 4734 | OH | TYR | B | 237 | 4802 | 5121 | 3010 | 823 | 725 | −411 | O |
| ATOM | 4735 | N | ILE | B | 238 | −2.319 | 49.455 | 47.306 | 1.00 | 35.79 | | N |
| ANISOU | 4735 | N | ILE | B | 238 | 6118 | 4982 | 2497 | 978 | −385 | −763 | N |
| ATOM | 4736 | CA | ILE | B | 238 | −0.991 | 48.910 | 47.479 | 1.00 | 39.54 | | C |
| ANISOU | 4736 | CA | ILE | B | 238 | 6623 | 5382 | 3018 | 933 | −645 | −809 | C |
| ATOM | 4737 | C | ILE | B | 238 | −1.022 | 47.741 | 48.465 | 1.00 | 45.03 | | C |
| ANISOU | 4737 | C | ILE | B | 238 | 7522 | 6077 | 3512 | 1004 | −614 | −742 | C |
| ATOM | 4738 | O | ILE | B | 238 | −1.710 | 47.781 | 49.482 | 1.00 | 43.57 | | O |
| ANISOU | 4738 | O | ILE | B | 238 | 7579 | 5883 | 3092 | 1141 | −485 | −714 | O |
| ATOM | 4739 | CB | ILE | B | 238 | −0.008 | 50.025 | 47.917 | 1.00 | 43.26 | | C |
| ANISOU | 4739 | CB | ILE | B | 238 | 7225 | 5716 | 3496 | 983 | −937 | −958 | C |
| ATOM | 4740 | CG1 | ILE | B | 238 | 0.163 | 51.009 | 46.758 | 1.00 | 40.10 | | C |
| ANISOU | 4740 | CG1 | ILE | B | 238 | 6573 | 5314 | 3348 | 882 | −967 | −1000 | C |
| ATOM | 4741 | CG2 | ILE | B | 238 | 1.362 | 49.477 | 48.275 | 1.00 | 33.48 | | C |
| ANISOU | 4741 | CG2 | ILE | B | 238 | 6032 | 4374 | 2315 | 955 | −1229 | −1000 | C |
| ATOM | 4742 | CD1 | ILE | B | 238 | 1.169 | 52.095 | 47.014 | 1.00 | 39.69 | | C |
| ANISOU | 4742 | CD1 | ILE | B | 238 | 6589 | 5116 | 3377 | 902 | −1259 | −1132 | C |
| ATOM | 4743 | N | VAL | B | 239 | −0.298 | 46.682 | 48.121 | 1.00 | 44.65 | | N |
| ANISOU | 4743 | N | VAL | B | 239 | 7359 | 6030 | 3576 | 908 | −709 | −702 | N |
| ATOM | 4744 | CA | VAL | B | 239 | −0.249 | 45.483 | 48.937 | 1.00 | 48.18 | | C |
| ANISOU | 4744 | CA | VAL | B | 239 | 7972 | 6472 | 3863 | 957 | −693 | −629 | C |
| ATOM | 4745 | C | VAL | B | 239 | 0.430 | 45.785 | 50.267 | 1.00 | 59.44 | | C |
| ANISOU | 4745 | C | VAL | B | 239 | 9685 | 7762 | 5138 | 1072 | −894 | −698 | C |
| ATOM | 4746 | O | VAL | B | 239 | 1.453 | 46.473 | 50.298 | 1.00 | 62.28 | | O |
| ANISOU | 4746 | O | VAL | B | 239 | 10029 | 8012 | 5621 | 1052 | −1154 | −800 | O |
| ATOM | 4747 | CB | VAL | B | 239 | 0.505 | 44.350 | 48.211 | 1.00 | 44.66 | | C |
| ANISOU | 4747 | CB | VAL | B | 239 | 7319 | 6039 | 3610 | 822 | −777 | −581 | C |
| ATOM | 4748 | CG1 | VAL | B | 239 | 0.726 | 43.158 | 49.145 | 1.00 | 46.43 | | C |
| ANISOU | 4748 | CG1 | VAL | B | 239 | 7737 | 6234 | 3670 | 879 | −811 | −519 | C |
| ATOM | 4749 | CG2 | VAL | B | 239 | −0.266 | 43.916 | 46.974 | 1.00 | 35.87 | | C |
| ANISOU | 4749 | CG2 | VAL | B | 239 | 5920 | 5037 | 2671 | 700 | −557 | −488 | C |
| ATOM | 4750 | O | ARG | B | 240 | −0.958 | 47.430 | 53.346 | 1.00 | 81.10 | | O |
| ANISOU | 4750 | O | ARG | B | 240 | 13087 | 10318 | 7410 | 1453 | −688 | −709 | O |
| ATOM | 4751 | N | ARG | B | 240 | −0.162 | 45.278 | 51.349 | 1.00 | 63.62 | | N |
| ANISOU | 4751 | N | ARG | B | 240 | 10424 | 8278 | 5470 | 1173 | −748 | −618 | N |
| ATOM | 4752 | CA | ARG | B | 240 | 0.309 | 45.478 | 52.720 | 1.00 | 68.02 | | C |
| ANISOU | 4752 | CA | ARG | B | 240 | 11252 | 8692 | 5900 | 1287 | −887 | −653 | C |
| ATOM | 4753 | C | ARG | B | 240 | 0.156 | 46.928 | 53.171 | 1.00 | 77.02 | | C |
| ANISOU | 4753 | C | ARG | B | 240 | 12514 | 9753 | 6998 | 1378 | −930 | −744 | C |
| ATOM | 4754 | CB | ARG | B | 240 | 1.764 | 45.043 | 52.857 | 1.00 | 67.99 | | C |
| ANISOU | 4754 | CB | ARG | B | 240 | 11240 | 8581 | 6013 | 1237 | −1213 | −707 | C |
| ATOM | 4755 | CG | ARG | B | 240 | 1.993 | 43.562 | 52.630 | 1.00 | 76.24 | | C |
| ANISOU | 4755 | CG | ARG | B | 240 | 12214 | 9677 | 7077 | 1170 | −1194 | −618 | C |
| ATOM | 4756 | CD | ARG | B | 240 | 3.470 | 43.200 | 52.784 | 1.00 | 86.55 | | C |
| ANISOU | 4756 | CD | ARG | B | 240 | 13496 | 10860 | 8530 | 1128 | −1522 | −672 | C |
| ATOM | 4757 | NE | ARG | B | 240 | 4.325 | 44.386 | 52.824 | 1.00 | 89.34 | | N |
| ANISOU | 4757 | NE | ARG | B | 240 | 13830 | 11089 | 9027 | 1130 | −1767 | −790 | N |
| ATOM | 4758 | CZ | ARG | B | 240 | 4.837 | 44.900 | 53.938 | 1.00 | 87.13 | | C |
| ANISOU | 4758 | CZ | ARG | B | 240 | 13774 | 10650 | 8683 | 1231 | −1948 | −847 | C |
| ATOM | 4759 | NH1 | ARG | B | 240 | 4.580 | 44.325 | 55.105 | 1.00 | 87.39 | | N |
| ANISOU | 4759 | NH1 | ARG | B | 240 | 14079 | 10632 | 8494 | 1343 | −1906 | −801 | N |
| ATOM | 4760 | NH2 | ARG | B | 240 | 5.595 | 45.987 | 53.882 | 1.00 | 84.34 | | N |
| ANISOU | 4760 | NH2 | ARG | B | 240 | 13379 | 10177 | 8488 | 1223 | −2171 | −944 | N |
| ATOM | 4761 | O | ALA | B | 273 | 4.372 | 50.498 | 52.094 | 1.00 | 73.84 | | O |
| ANISOU | 4761 | O | ALA | B | 273 | 11781 | 8888 | 7386 | 1194 | −2059 | −1160 | O |
| ATOM | 4762 | N | ALA | B | 273 | 2.435 | 49.472 | 54.082 | 1.00 | 67.17 | | N |
| ANISOU | 4762 | N | ALA | B | 273 | 11459 | 8122 | 5942 | 1451 | −1638 | −1030 | N |
| ATOM | 4763 | CA | ALA | B | 273 | 2.224 | 49.595 | 52.639 | 1.00 | 63.01 | | C |
| ANISOU | 4763 | CA | ALA | B | 273 | 10620 | 7725 | 5595 | 1315 | −1547 | −1029 | C |
| ATOM | 4764 | C | ALA | B | 273 | 3.540 | 49.618 | 51.871 | 1.00 | 63.85 | | C |
| ANISOU | 4764 | C | ALA | B | 273 | 10500 | 7769 | 5991 | 1186 | −1818 | −1082 | C |
| ATOM | 4765 | CB | ALA | B | 273 | 1.416 | 50.843 | 52.318 | 1.00 | 55.79 | | C |
| ANISOU | 4765 | CB | ALA | B | 273 | 9690 | 6844 | 4665 | 1351 | −1420 | −1072 | C |
| ATOM | 4766 | O | GLU | B | 274 | 4.233 | 50.608 | 49.117 | 1.00 | 44.27 | | O |
| ANISOU | 4766 | O | GLU | B | 274 | 7414 | 5366 | 4040 | 924 | −1899 | −1152 | O |
| ATOM | 4767 | N | GLU | B | 274 | 3.726 | 48.635 | 50.990 | 1.00 | 53.86 | | N |
| ANISOU | 4767 | N | GLU | B | 274 | 9024 | 6602 | 4839 | 1073 | −1773 | −1029 | N |
| ATOM | 4768 | CA | GLU | B | 274 | 4.911 | 48.549 | 50.142 | 1.00 | 49.07 | | C |
| ANISOU | 4768 | CA | GLU | B | 274 | 8167 | 5944 | 4532 | 948 | −1980 | −1058 | C |
| ATOM | 4769 | C | GLU | B | 274 | 5.168 | 49.879 | 49.439 | 1.00 | 48.47 | | C |
| ANISOU | 4769 | C | GLU | B | 274 | 7939 | 5822 | 4654 | 900 | −2062 | −1134 | C |
| ATOM | 4770 | CB | GLU | B | 274 | 4.751 | 47.447 | 49.087 | 1.00 | 55.61 | | C |
| ANISOU | 4770 | CB | GLU | B | 274 | 8784 | 6912 | 5433 | 844 | −1852 | −989 | C |
| ATOM | 4771 | CG | GLU | B | 274 | 4.821 | 46.012 | 49.594 | 1.00 | 61.70 | | C |
| ANISOU | 4771 | CG | GLU | B | 274 | 9645 | 7707 | 6092 | 859 | −1825 | −909 | C |
| ATOM | 4772 | CD | GLU | B | 274 | 4.758 | 44.991 | 48.450 | 1.00 | 68.22 | | C |
| ANISOU | 4772 | CD | GLU | B | 274 | 10249 | 8651 | 7018 | 753 | −1731 | −847 | C |
| ATOM | 4773 | OE1 | GLU | B | 274 | 4.905 | 45.399 | 47.273 | 1.00 | 65.00 | | O |
| ANISOU | 4773 | OE1 | GLU | B | 274 | 9570 | 8278 | 6851 | 649 | −1678 | −850 | O |
| ATOM | 4774 | OE2 | GLU | B | 274 | 4.554 | 43.783 | 48.727 | 1.00 | 70.68 | | O |
| ANISOU | 4774 | OE2 | GLU | B | 274 | 10623 | 9008 | 7224 | 761 | −1653 | −765 | O |
| ATOM | 4775 | N | LYS | B | 275 | 6.433 | 50.204 | 49.199 | 1.00 | 51.73 | | N |
| ANISOU | 4775 | N | LYS | B | 275 | 8206 | 6103 | 5345 | 836 | −2307 | −1169 | N |
| ATOM | 4776 | CA | LYS | B | 275 | 6.750 | 51.493 | 48.600 | 1.00 | 51.75 | | C |
| ANISOU | 4776 | CA | LYS | B | 275 | 8067 | 6038 | 5557 | 791 | −2391 | −1228 | C |
| ATOM | 4777 | C | LYS | B | 275 | 6.927 | 51.392 | 47.070 | 1.00 | 49.48 | | C |
| ANISOU | 4777 | C | LYS | B | 275 | 7448 | 5834 | 5519 | 652 | −2315 | −1205 | C |
| ATOM | 4778 | O | LYS | B | 275 | 7.289 | 50.351 | 46.526 | 1.00 | 43.72 | | O |
| ANISOU | 4778 | O | LYS | B | 275 | 6571 | 5156 | 4886 | 581 | −2289 | −1150 | O |
| ATOM | 4779 | CB | LYS | B | 275 | 7.990 | 52.112 | 49.262 | 1.00 | 48.20 | | C |
| ANISOU | 4779 | CB | LYS | B | 275 | 7653 | 5367 | 5291 | 814 | −2694 | −1270 | C |
| ATOM | 4780 | CG | LYS | B | 275 | 9.255 | 51.313 | 49.143 | 1.00 | 60.55 | | C |
| ANISOU | 4780 | CG | LYS | B | 275 | 9066 | 6841 | 7100 | 747 | −2863 | −1232 | C |
| ATOM | 4781 | CD | LYS | B | 275 | 10.414 | 52.033 | 49.831 | 1.00 | 73.56 | | C |
| ANISOU | 4781 | CD | LYS | B | 275 | 10757 | 8252 | 8940 | 781 | −3165 | −1272 | C |
| ATOM | 4782 | CE | LYS | B | 275 | 10.791 | 53.326 | 49.090 | 1.00 | 76.97 | | C |
| ANISOU | 4782 | CE | LYS | B | 275 | 10995 | 8607 | 9645 | 720 | −3227 | −1301 | C |
| ATOM | 4783 | NZ | LYS | B | 275 | 11.944 | 54.069 | 49.704 | 1.00 | 75.88 | | N |
| ANISOU | 4783 | NZ | LYS | B | 275 | 10881 | 8220 | 9732 | 750 | −3531 | −1331 | N |
| ATOM | 4784 | N | VAL | B | 276 | 6.635 | 52.490 | 46.385 | 1.00 | 51.16 | | N |
| ANISOU | 4784 | N | VAL | B | 276 | 7556 | 6052 | 5829 | 621 | −2272 | −1245 | N |
| ATOM | 4785 | CA | VAL | B | 276 | 6.754 | 52.559 | 44.938 | 1.00 | 48.27 | | C |
| ANISOU | 4785 | CA | VAL | B | 276 | 6893 | 5748 | 5698 | 501 | −2192 | −1226 | C |
| ATOM | 4786 | C | VAL | B | 276 | 8.213 | 52.583 | 44.492 | 1.00 | 48.49 | | C |
| ANISOU | 4786 | C | VAL | B | 276 | 6688 | 5638 | 6099 | 412 | −2361 | −1197 | C |
| ATOM | 4787 | O | VAL | B | 276 | 9.017 | 53.376 | 44.973 | 1.00 | 50.00 | | O |
| ANISOU | 4787 | O | VAL | B | 276 | 6893 | 5663 | 6442 | 430 | −2549 | −1222 | O |
| ATOM | 4788 | CB | VAL | B | 276 | 6.046 | 53.816 | 44.394 | 1.00 | 43.28 | | C |
| ANISOU | 4788 | CB | VAL | B | 276 | 6222 | 5143 | 5080 | 499 | −2083 | −1261 | C |
| ATOM | 4789 | CG1 | VAL | B | 276 | 6.190 | 53.911 | 42.892 | 1.00 | 44.22 | | C |
| ANISOU | 4789 | CG1 | VAL | B | 276 | 6026 | 5313 | 5462 | 375 | −1915 | −1182 | C |
| ATOM | 4790 | CG2 | VAL | B | 276 | 4.601 | 53.809 | 44.805 | 1.00 | 42.83 | | C |
| ANISOU | 4790 | CG2 | VAL | B | 276 | 6357 | 5213 | 4701 | 590 | −1860 | −1256 | C |
| ATOM | 4791 | N | VAL | B | 277 | 8.529 | 51.730 | 43.533 | 1.00 | 50.31 | | N |
| ANISOU | 4791 | N | VAL | B | 277 | 6696 | 5932 | 6488 | 324 | −2265 | −1129 | N |
| ATOM | 4792 | CA | VAL | B | 277 | 9.849 | 51.700 | 42.934 | 1.00 | 48.57 | | C |
| ANISOU | 4792 | CA | VAL | B | 277 | 6220 | 5591 | 6643 | 244 | −2368 | −1085 | C |
| ATOM | 4793 | C | VAL | B | 277 | 9.890 | 52.532 | 41.652 | 1.00 | 30.94 | | C |
| ANISOU | 4793 | C | VAL | B | 277 | 3747 | 3362 | 4647 | 163 | −2228 | −1052 | C |
| ATOM | 4794 | O | VAL | B | 277 | 9.171 | 52.248 | 40.691 | 1.00 | 37.20 | | O |
| ANISOU | 4794 | O | VAL | B | 277 | 4461 | 4295 | 5378 | 128 | −1942 | −985 | O |
| ATOM | 4795 | CB | VAL | B | 277 | 10.254 | 50.271 | 42.638 | 1.00 | 45.99 | | C |
| ANISOU | 4795 | CB | VAL | B | 277 | 5794 | 5313 | 6366 | 209 | −2309 | −1012 | C |
| ATOM | 4796 | CG1 | VAL | B | 277 | 11.633 | 50.248 | 42.017 | 1.00 | 50.46 | | C |
| ANISOU | 4796 | CG1 | VAL | B | 277 | 6090 | 5745 | 7337 | 140 | −2380 | −953 | C |
| ATOM | 4797 | CG2 | VAL | B | 277 | 10.243 | 49.478 | 43.926 | 1.00 | 50.92 | | C |
| ANISOU | 4797 | CG2 | VAL | B | 277 | 6665 | 5922 | 6761 | 291 | −2434 | −1029 | C |
| ATOM | 4798 | N | TRP | B | 278 | 10.723 | 53.565 | 41.657 | 1.00 | 37.46 | | N |
| ANISOU | 4798 | N | TRP | B | 278 | 4480 | 4024 | 5730 | 144 | −2377 | −1065 | N |
| ATOM | 4799 | CA | TRP | B | 278 | 10.753 | 54.569 | 40.596 | 1.00 | 37.36 | | C |
| ANISOU | 4799 | CA | TRP | B | 278 | 4273 | 3986 | 5935 | 79 | −2280 | −1043 | C |
| ATOM | 4800 | C | TRP | B | 278 | 11.901 | 54.397 | 39.603 | 1.00 | 36.24 | | C |
| ANISOU | 4800 | C | TRP | B | 278 | 3832 | 3757 | 6180 | −1 | −2213 | −936 | C |
| ATOM | 4801 | O | TRP | B | 278 | 13.010 | 54.069 | 39.986 | 1.00 | 42.20 | | O |
| ANISOU | 4801 | O | TRP | B | 278 | 4530 | 4382 | 7123 | 4 | −2336 | −896 | O |
| ATOM | 4802 | CB | TRP | B | 278 | 10.844 | 55.971 | 41.217 | 1.00 | 41.76 | | C |
| ANISOU | 4802 | CB | TRP | B | 278 | 4937 | 4411 | 6519 | 122 | −2435 | −1104 | C |
| ATOM | 4803 | CG | TRP | B | 278 | 9.601 | 56.430 | 41.917 | 1.00 | 40.24 | | C |
| ANISOU | 4803 | CG | TRP | B | 278 | 5014 | 4303 | 5974 | 206 | −2430 | −1199 | C |
| ATOM | 4804 | CD1 | TRP | B | 278 | 9.414 | 56.579 | 43.266 | 1.00 | 38.30 | | C |
| ANISOU | 4804 | CD1 | TRP | B | 278 | 5048 | 4005 | 5499 | 313 | −2575 | −1264 | C |
| ATOM | 4805 | CD2 | TRP | B | 278 | 8.359 | 56.800 | 41.295 | 1.00 | 37.07 | | C |
| ANISOU | 4805 | CD2 | TRP | B | 278 | 4633 | 4045 | 5405 | 204 | −2225 | −1219 | C |
| ATOM | 4806 | NE1 | TRP | B | 278 | 8.129 | 57.030 | 43.519 | 1.00 | 39.80 | | N |
| ANISOU | 4806 | NE1 | TRP | B | 278 | 5429 | 4299 | 5395 | 382 | −2471 | −1328 | N |
| ATOM | 4807 | CE2 | TRP | B | 278 | 7.461 | 57.161 | 42.325 | 1.00 | 36.42 | | C |
| ANISOU | 4807 | CE2 | TRP | B | 278 | 4841 | 3991 | 5006 | 315 | −2272 | −1311 | C |
| ATOM | 4808 | CE3 | TRP | B | 278 | 7.917 | 56.849 | 39.966 | 1.00 | 29.82 | | C |
| ANISOU | 4808 | CE3 | TRP | B | 278 | 3536 | 3234 | 4560 | 138 | −1942 | −1130 | C |
| ATOM | 4809 | CZ2 | TRP | B | 278 | 6.158 | 57.572 | 42.067 | 1.00 | 31.07 | | C |
| ANISOU | 4809 | CZ2 | TRP | B | 278 | 4241 | 3442 | 4121 | 353 | −2044 | −1310 | C |
| ATOM | 4810 | CZ3 | TRP | B | 278 | 6.622 | 57.245 | 39.708 | 1.00 | 29.75 | | C |
| ANISOU | 4810 | CZ3 | TRP | B | 278 | 3617 | 3350 | 4336 | 171 | −1747 | −1135 | C |
| ATOM | 4811 | CH2 | TRP | B | 278 | 5.755 | 57.609 | 40.753 | 1.00 | 34.16 | | C |
| ANISOU | 4811 | CH2 | TRP | B | 278 | 4428 | 3933 | 4617 | 275 | −1796 | −1222 | C |
| ATOM | 4812 | N | GLU | B | 279 | 11.650 | 54.671 | 38.330 | 1.00 | 33.10 | | N |
| ANISOU | 4812 | N | GLU | B | 279 | 3265 | 3420 | 5891 | −59 | −1982 | −873 | N |
| ATOM | 4813 | CA | GLU | B | 279 | 12.715 | 54.666 | 37.331 | 1.00 | 35.48 | | C |
| ANISOU | 4813 | CA | GLU | B | 279 | 3288 | 3624 | 6568 | −122 | −1888 | −764 | C |
| ATOM | 4814 | C | GLU | B | 279 | 12.579 | 55.830 | 36.360 | 1.00 | 39.09 | | C |
| ANISOU | 4814 | C | GLU | B | 279 | 3626 | 4051 | 7177 | −163 | −1747 | −724 | C |
| ATOM | 4815 | O | GLU | B | 279 | 11.475 | 56.160 | 35.928 | 1.00 | 35.56 | | O |
| ANISOU | 4815 | O | GLU | B | 279 | 3286 | 3732 | 6492 | −151 | −1574 | −735 | O |
| ATOM | 4816 | CB | GLU | B | 279 | 12.715 | 53.363 | 36.547 | 1.00 | 41.06 | | C |
| ANISOU | 4816 | CB | GLU | B | 279 | 3925 | 4442 | 7235 | −133 | −1646 | −675 | C |
| ATOM | 4817 | CG | GLU | B | 279 | 13.020 | 52.132 | 37.371 | 1.00 | 48.70 | | C |
| ANISOU | 4817 | CG | GLU | B | 279 | 4966 | 5421 | 8116 | −102 | −1775 | −694 | C |
| ATOM | 4818 | CD | GLU | B | 279 | 14.427 | 52.127 | 37.936 | 1.00 | 57.71 | | C |
| ANISOU | 4818 | CD | GLU | B | 279 | 6013 | 6366 | 9549 | −97 | −1979 | −667 | C |
| ATOM | 4819 | OE1 | GLU | B | 279 | 15.359 | 52.658 | 37.282 | 1.00 | 62.63 | | O |
| ANISOU | 4819 | OE1 | GLU | B | 279 | 6444 | 6858 | 10496 | −127 | −1913 | −583 | O |
| ATOM | 4820 | OE2 | GLU | B | 279 | 14.596 | 51.586 | 39.045 | 1.00 | 55.15 | | O |
| ANISOU | 4820 | OE2 | GLU | B | 279 | 5839 | 6013 | 9102 | −52 | −2173 | −715 | O |
| ATOM | 4821 | N | ASN | B | 280 | 13.704 | 56.436 | 35.999 | 1.00 | 32.64 | | N |
| ANISOU | 4821 | N | ASN | B | 280 | 2644 | 3063 | 6696 | −187 | −1753 | −641 | N |
| ATOM | 4822 | CA | ASN | B | 280 | 13.708 | 57.476 | 34.982 | 1.00 | 42.06 | | C |
| ANISOU | 4822 | CA | ASN | B | 280 | 3709 | 4210 | 8061 | −225 | −1595 | −576 | C |
| ATOM | 4823 | C | ASN | B | 280 | 13.369 | 56.942 | 33.607 | 1.00 | 37.37 | | C |
| ANISOU | 4823 | C | ASN | B | 280 | 2997 | 3731 | 7472 | −257 | −1273 | −483 | C |
| ATOM | 4824 | O | ASN | B | 280 | 13.865 | 55.899 | 33.208 | 1.00 | 39.22 | | O |
| ANISOU | 4824 | O | ASN | B | 280 | 3149 | 3984 | 7768 | −254 | −1149 | −411 | O |
| ATOM | 4825 | CB | ASN | B | 280 | 15.072 | 58.177 | 34.949 | 1.00 | 47.70 | | C |
| ANISOU | 4825 | CB | ASN | B | 280 | 4280 | 4699 | 9144 | −232 | −1669 | −493 | C |
| ATOM | 4826 | CG | ASN | B | 280 | 15.360 | 58.907 | 36.232 | 1.00 | 51.81 | | C |
| ANISOU | 4826 | CG | ASN | B | 280 | 4925 | 5084 | 9674 | −194 | −1993 | −583 | C |
| ATOM | 4827 | OD1 | ASN | B | 280 | 14.432 | 59.209 | 36.983 | 1.00 | 51.53 | | O |
| ANISOU | 4827 | OD1 | ASN | B | 280 | 5093 | 5123 | 9362 | −160 | −2120 | −704 | O |
| ATOM | 4828 | ND2 | ASN | B | 280 | 16.637 | 59.181 | 36.510 | 1.00 | 53.85 | | N |
| ANISOU | 4828 | ND2 | ASN | B | 280 | 5078 | 5135 | 10248 | −187 | −2126 | −524 | N |
| ATOM | 4829 | N | VAL | B | 281 | 12.527 | 57.658 | 32.872 | 1.00 | 37.32 | | N |
| ANISOU | 4829 | N | VAL | B | 281 | 3049 | 3797 | 7333 | −260 | −1100 | −471 | N |
| ATOM | 4830 | CA | VAL | B | 281 | 12.310 | 57.299 | 31.477 | 1.00 | 43.77 | | C |
| ANISOU | 4830 | CA | VAL | B | 281 | 3827 | 4691 | 8111 | −262 | −765 | −359 | C |
| ATOM | 4831 | C | VAL | B | 281 | 13.565 | 57.670 | 30.678 | 1.00 | 45.76 | | C |
| ANISOU | 4831 | C | VAL | B | 281 | 3828 | 4774 | 8784 | −294 | −654 | −226 | C |
| ATOM | 4832 | O | VAL | B | 281 | 14.200 | 58.682 | 30.957 | 1.00 | 43.84 | | O |
| ANISOU | 4832 | O | VAL | B | 281 | 3515 | 4375 | 8767 | −309 | −783 | −214 | O |
| ATOM | 4833 | CB | VAL | B | 281 | 11.069 | 57.993 | 30.896 | 1.00 | 40.05 | | C |
| ANISOU | 4833 | CB | VAL | B | 281 | 3495 | 4329 | 7393 | −251 | −632 | −377 | C |
| ATOM | 4834 | CG1 | VAL | B | 281 | 10.950 | 57.718 | 29.418 | 1.00 | 38.72 | | C |
| ANISOU | 4834 | CG1 | VAL | B | 281 | 3305 | 4205 | 7201 | −247 | −317 | −260 | C |
| ATOM | 4835 | CG2 | VAL | B | 281 | 9.817 | 57.505 | 31.606 | 1.00 | 34.56 | | C |
| ANISOU | 4835 | CG2 | VAL | B | 281 | 3019 | 3799 | 6314 | −214 | −695 | −482 | C |
| ATOM | 4836 | N | THR | B | 282 | 13.940 | 56.840 | 29.707 | 1.00 | 42.92 | | N |
| ANISOU | 4836 | N | THR | B | 282 | 3403 | 4436 | 8467 | −277 | −393 | −115 | N |
| ATOM | 4837 | CA | THR | B | 282 | 15.203 | 57.031 | 28.993 | 1.00 | 45.18 | | C |
| ANISOU | 4837 | CA | THR | B | 282 | 3531 | 4560 | 9076 | −270 | −243 | 30 | C |
| ATOM | 4838 | C | THR | B | 282 | 15.050 | 57.751 | 27.649 | 1.00 | 47.17 | | C |
| ANISOU | 4838 | C | THR | B | 282 | 3765 | 4791 | 9367 | −265 | 45 | 141 | C |
| ATOM | 4839 | O | THR | B | 282 | 16.039 | 57.977 | 26.960 | 1.00 | 50.69 | | O |
| ANISOU | 4839 | O | THR | B | 282 | 4117 | 5099 | 10042 | −242 | 203 | 273 | O |
| ATOM | 4840 | CB | THR | B | 282 | 15.913 | 55.676 | 28.740 | 1.00 | 51.08 | | C |
| ANISOU | 4840 | CB | THR | B | 282 | 4233 | 5307 | 9868 | −234 | −118 | 96 | C |
| ATOM | 4841 | OG1 | THR | B | 282 | 15.181 | 54.915 | 27.772 | 1.00 | 43.80 | | O |
| ANISOU | 4841 | OG1 | THR | B | 282 | 3384 | 4528 | 8730 | −207 | 153 | 128 | O |
| ATOM | 4842 | CG2 | THR | B | 282 | 16.038 | 54.879 | 30.041 | 1.00 | 51.58 | | C |
| ANISOU | 4842 | CG2 | THR | B | 282 | 4328 | 5393 | 9877 | −235 | −396 | −7 | C |
| ATOM | 4843 | N | ARG | B | 283 | 13.817 | 58.064 | 27.250 | 1.00 | 52.90 | | N |
| ANISOU | 4843 | N | ARG | B | 283 | 4615 | 5648 | 9838 | −270 | 123 | 96 | N |
| ATOM | 4844 | CA | ARG | B | 283 | 13.570 | 58.823 | 26.018 | 1.00 | 52.67 | | C |
| ANISOU | 4844 | CA | ARG | B | 283 | 4610 | 5596 | 9805 | −259 | 373 | 195 | C |
| ATOM | 4845 | C | ARG | B | 283 | 12.479 | 59.875 | 26.256 | 1.00 | 48.73 | | C |
| ANISOU | 4845 | C | ARG | B | 283 | 4245 | 5155 | 9113 | −277 | 251 | 105 | C |
| ATOM | 4846 | O | ARG | B | 283 | 11.610 | 59.682 | 27.096 | 1.00 | 46.05 | | O |
| ANISOU | 4846 | O | ARG | B | 283 | 4045 | 4932 | 8519 | −274 | 68 | −28 | O |
| ATOM | 4847 | CB | ARG | B | 283 | 13.194 | 57.870 | 24.876 | 1.00 | 55.05 | | C |
| ANISOU | 4847 | CB | ARG | B | 283 | 5056 | 5999 | 9862 | −198 | 669 | 262 | C |
| ATOM | 4848 | CG | ARG | B | 283 | 14.307 | 56.866 | 24.533 | 1.00 | 63.62 | | C |
| ANISOU | 4848 | CG | ARG | B | 283 | 6014 | 7013 | 11146 | −164 | 831 | 362 | C |
| ATOM | 4849 | CD | ARG | B | 283 | 14.184 | 56.294 | 23.129 | 1.00 | 72.32 | | C |
| ANISOU | 4849 | CD | ARG | B | 283 | 7249 | 8145 | 12085 | −89 | 1178 | 466 | C |
| ATOM | 4850 | NE | ARG | B | 283 | 14.201 | 57.333 | 22.104 | 1.00 | 79.62 | | N |
| ANISOU | 4850 | NE | ARG | B | 283 | 8212 | 8990 | 13051 | −69 | 1370 | 571 | N |
| ATOM | 4851 | CZ | ARG | B | 283 | 13.666 | 57.198 | 20.894 | 1.00 | 80.61 | | C |
| ANISOU | 4851 | CZ | ARG | B | 283 | 8520 | 9157 | 12952 | −7 | 1633 | 635 | C |
| ATOM | 4852 | NH1 | ARG | B | 283 | 13.068 | 56.063 | 20.552 | 1.00 | 77.86 | | N |
| ANISOU | 4852 | NH1 | ARG | B | 283 | 8377 | 8924 | 12281 | 45 | 1690 | 589 | N |
| ATOM | 4853 | NH2 | ARG | B | 283 | 13.727 | 58.202 | 20.026 | 1.00 | 82.78 | | N |
| ANISOU | 4853 | NH2 | ARG | B | 283 | 8838 | 9345 | 13268 | 15 | 1785 | 733 | N |
| ATOM | 4854 | N | LYS | B | 284 | 12.532 | 60.996 | 25.542 | 1.00 | 54.96 | | N |
| ANISOU | 4854 | N | LYS | B | 284 | 4991 | 5855 | 10034 | −289 | 360 | 184 | N |
| ATOM | 4855 | CA | LYS | B | 284 | 11.682 | 62.148 | 25.873 | 1.00 | 54.70 | | C |
| ANISOU | 4855 | CA | LYS | B | 284 | 5046 | 5839 | 9900 | −308 | 214 | 101 | C |
| ATOM | 4856 | C | LYS | B | 284 | 10.188 | 61.921 | 25.636 | 1.00 | 49.91 | | C |
| ANISOU | 4856 | C | LYS | B | 284 | 4683 | 5419 | 8861 | −272 | 252 | 25 | C |
| ATOM | 4857 | O | LYS | B | 284 | 9.351 | 62.326 | 26.455 | 1.00 | 53.98 | | O |
| ANISOU | 4857 | O | LYS | B | 284 | 5294 | 5999 | 9217 | −273 | 60 | −98 | O |
| ATOM | 4858 | CB | LYS | B | 284 | 12.127 | 63.391 | 25.088 | 1.00 | 57.94 | | C |
| ANISOU | 4858 | CB | LYS | B | 284 | 5347 | 6096 | 10571 | −329 | 336 | 220 | C |
| ATOM | 4859 | CG | LYS | B | 284 | 13.276 | 64.163 | 25.728 | 1.00 | 61.09 | | C |
| ANISOU | 4859 | CG | LYS | B | 284 | 5542 | 6292 | 11376 | −370 | 157 | 244 | C |
| ATOM | 4860 | CD | LYS | B | 284 | 13.650 | 65.410 | 24.933 | 1.00 | 64.21 | | C |
| ANISOU | 4860 | CD | LYS | B | 284 | 5879 | 6543 | 11975 | −370 | 280 | 366 | C |
| ATOM | 4861 | CE | LYS | B | 284 | 14.845 | 66.127 | 25.556 | 1.00 | 70.33 | | C |
| ANISOU | 4861 | CE | LYS | B | 284 | 6515 | 7118 | 13090 | −370 | 88 | 392 | C |
| ATOM | 4862 | NZ | LYS | B | 284 | 15.156 | 67.422 | 24.869 | 1.00 | 73.70 | | N |
| ANISOU | 4862 | NZ | LYS | B | 284 | 6873 | 7402 | 13727 | −368 | 181 | 504 | N |
| ATOM | 4863 | N | TYR | B | 285 | 9.840 | 61.287 | 24.521 | 1.00 | 42.13 | | N |
| ANISOU | 4863 | N | TYR | B | 285 | 3806 | 4507 | 7695 | −232 | 494 | 100 | N |
| ATOM | 4864 | CA | TYR | B | 285 | 8.428 | 61.200 | 24.154 | 1.00 | 45.69 | | C |
| ANISOU | 4864 | CA | TYR | B | 285 | 4470 | 5104 | 7787 | −204 | 518 | 46 | C |
| ATOM | 4865 | C | TYR | B | 285 | 7.858 | 59.787 | 24.137 | 1.00 | 45.03 | | C |
| ANISOU | 4865 | C | TYR | B | 285 | 4516 | 5163 | 7432 | −175 | 548 | 5 | C |
| ATOM | 4866 | O | TYR | B | 285 | 6.750 | 59.570 | 23.638 | 1.00 | 44.48 | | O |
| ANISOU | 4866 | O | TYR | B | 285 | 4611 | 5195 | 7094 | −150 | 588 | −15 | O |
| ATOM | 4867 | CB | TYR | B | 285 | 8.210 | 61.868 | 22.802 | 1.00 | 49.95 | | C |
| ANISOU | 4867 | CB | TYR | B | 285 | 5081 | 5598 | 8299 | −179 | 729 | 154 | C |
| ATOM | 4868 | CG | TYR | B | 285 | 8.840 | 63.229 | 22.765 | 1.00 | 53.51 | | C |
| ANISOU | 4868 | CG | TYR | B | 285 | 5392 | 5893 | 9046 | −211 | 718 | 213 | C |
| ATOM | 4869 | CD1 | TYR | B | 285 | 8.380 | 64.243 | 23.599 | 1.00 | 51.38 | | C |
| ANISOU | 4869 | CD1 | TYR | B | 285 | 5104 | 5608 | 8809 | −242 | 500 | 117 | C |
| ATOM | 4870 | CD2 | TYR | B | 285 | 9.916 | 63.499 | 21.927 | 1.00 | 54.30 | | C |
| ANISOU | 4870 | CD2 | TYR | B | 285 | 5375 | 5847 | 9408 | −207 | 930 | 370 | C |
| ATOM | 4871 | CE1 | TYR | B | 285 | 8.968 | 65.497 | 23.592 | 1.00 | 54.74 | | C |
| ANISOU | 4871 | CE1 | TYR | B | 285 | 5401 | 5874 | 9523 | −276 | 466 | 167 | C |
| ATOM | 4872 | CE2 | TYR | B | 285 | 10.508 | 64.751 | 21.912 | 1.00 | 56.17 | | C |
| ANISOU | 4872 | CE2 | TYR | B | 285 | 5465 | 5925 | 9952 | −244 | 916 | 436 | C |
| ATOM | 4873 | CZ | TYR | B | 285 | 10.029 | 65.747 | 22.747 | 1.00 | 57.36 | | C |
| ANISOU | 4873 | CZ | TYR | B | 285 | 5602 | 6061 | 10133 | −283 | 669 | 330 | C |
| ATOM | 4874 | OH | TYR | B | 285 | 10.609 | 67.000 | 22.734 | 1.00 | 60.66 | | O |
| ANISOU | 4874 | OH | TYR | B | 285 | 5877 | 6306 | 10866 | −324 | 635 | 393 | O |
| ATOM | 4875 | N | TYR | B | 286 | 8.623 | 58.831 | 24.669 | 1.00 | 47.14 | | N |
| ANISOU | 4875 | N | TYR | B | 286 | 4700 | 5422 | 7788 | −178 | 515 | −1 | N |
| ATOM | 4876 | CA | TYR | B | 286 | 8.189 | 57.441 | 24.736 | 1.00 | 36.86 | | C |
| ANISOU | 4876 | CA | TYR | B | 286 | 3507 | 4239 | 6260 | −155 | 530 | −37 | C |
| ATOM | 4877 | C | TYR | B | 286 | 8.485 | 56.832 | 26.104 | 1.00 | 36.99 | | C |
| ANISOU | 4877 | C | TYR | B | 286 | 3460 | 4281 | 6314 | −174 | 326 | −124 | C |
| ATOM | 4878 | O | TYR | B | 286 | 9.395 | 57.274 | 26.798 | 1.00 | 39.81 | | O |
| ANISOU | 4878 | O | TYR | B | 286 | 3669 | 4532 | 6925 | −199 | 206 | −130 | O |
| ATOM | 4879 | CB | TYR | B | 286 | 8.874 | 56.624 | 23.652 | 1.00 | 39.60 | | C |
| ANISOU | 4879 | CB | TYR | B | 286 | 3864 | 4543 | 6640 | −115 | 767 | 72 | C |
| ATOM | 4880 | CG | TYR | B | 286 | 8.766 | 57.225 | 22.280 | 1.00 | 40.10 | | C |
| ANISOU | 4880 | CG | TYR | B | 286 | 4010 | 4553 | 6674 | −80 | 985 | 173 | C |
| ATOM | 4881 | CD1 | TYR | B | 286 | 7.564 | 57.191 | 21.581 | 1.00 | 40.00 | | C |
| ANISOU | 4881 | CD1 | TYR | B | 286 | 4208 | 4625 | 6366 | −54 | 1016 | 154 | C |
| ATOM | 4882 | CD2 | TYR | B | 286 | 9.865 | 57.816 | 21.676 | 1.00 | 44.19 | | C |
| ANISOU | 4882 | CD2 | TYR | B | 286 | 4400 | 4922 | 7467 | −68 | 1157 | 298 | C |
| ATOM | 4883 | CE1 | TYR | B | 286 | 7.456 | 57.733 | 20.316 | 1.00 | 46.17 | | C |
| ANISOU | 4883 | CE1 | TYR | B | 286 | 5099 | 5347 | 7095 | −11 | 1200 | 246 | C |
| ATOM | 4884 | CE2 | TYR | B | 286 | 9.768 | 58.370 | 20.415 | 1.00 | 54.54 | | C |
| ANISOU | 4884 | CE2 | TYR | B | 286 | 5814 | 6177 | 8732 | −24 | 1374 | 401 | C |
| ATOM | 4885 | CZ | TYR | B | 286 | 8.561 | 58.325 | 19.737 | 1.00 | 56.19 | | C |
| ANISOU | 4885 | CZ | TYR | B | 286 | 6262 | 6474 | 8612 | 7 | 1388 | 371 | C |
| ATOM | 4886 | OH | TYR | B | 286 | 8.455 | 58.871 | 18.480 | 1.00 | 61.98 | | O |
| ANISOU | 4886 | OH | TYR | B | 286 | 7130 | 7142 | 9276 | 60 | 1588 | 473 | O |
| ATOM | 4887 | N | TYR | B | 287 | 7.731 | 55.809 | 26.484 | 1.00 | 28.56 | | N |
| ANISOU | 4887 | N | TYR | B | 287 | 2510 | 3339 | 5004 | −162 | 279 | −185 | N |
| ATOM | 4888 | CA | TYR | B | 287 | 7.901 | 55.201 | 27.796 | 1.00 | 28.20 | | C |
| ANISOU | 4888 | CA | TYR | B | 287 | 2442 | 3322 | 4950 | −170 | 92 | −264 | C |
| ATOM | 4889 | C | TYR | B | 287 | 8.898 | 54.035 | 27.769 | 1.00 | 30.96 | | C |
| ANISOU | 4889 | C | TYR | B | 287 | 2718 | 3634 | 5410 | −161 | 139 | −218 | C |
| ATOM | 4890 | O | TYR | B | 287 | 8.504 | 52.871 | 27.836 | 1.00 | 34.70 | | O |
| ANISOU | 4890 | O | TYR | B | 287 | 3283 | 4197 | 5707 | −146 | 157 | −235 | O |
| ATOM | 4891 | CB | TYR | B | 287 | 6.563 | 54.702 | 28.324 | 1.00 | 27.37 | | C |
| ANISOU | 4891 | CB | TYR | B | 287 | 2490 | 3363 | 4546 | −160 | 23 | −341 | C |
| ATOM | 4892 | CG | TYR | B | 287 | 5.478 | 55.736 | 28.333 | 1.00 | 31.29 | | C |
| ANISOU | 4892 | CG | TYR | B | 287 | 3058 | 3902 | 4928 | −157 | −7 | −382 | C |
| ATOM | 4893 | CD1 | TYR | B | 287 | 5.685 | 56.990 | 28.924 | 1.00 | 24.85 | | C |
| ANISOU | 4893 | CD1 | TYR | B | 287 | 2191 | 3012 | 4239 | −164 | −126 | −425 | C |
| ATOM | 4894 | CD2 | TYR | B | 287 | 4.239 | 55.472 | 27.741 | 1.00 | 26.19 | | C |
| ANISOU | 4894 | CD2 | TYR | B | 287 | 2529 | 3356 | 4064 | −146 | 70 | −377 | C |
| ATOM | 4895 | CE1 | TYR | B | 287 | 4.689 | 57.952 | 28.933 | 1.00 | 23.00 | | C |
| ANISOU | 4895 | CE1 | TYR | B | 287 | 2024 | 2811 | 3906 | −152 | −148 | −462 | C |
| ATOM | 4896 | CE2 | TYR | B | 287 | 3.225 | 56.439 | 27.745 | 1.00 | 24.36 | | C |
| ANISOU | 4896 | CE2 | TYR | B | 287 | 2347 | 3156 | 3751 | −139 | 41 | −408 | C |
| ATOM | 4897 | CZ | TYR | B | 287 | 3.459 | 57.668 | 28.346 | 1.00 | 26.27 | | C |
| ANISOU | 4897 | CZ | TYR | B | 287 | 2540 | 3332 | 4111 | −139 | −57 | −451 | C |
| ATOM | 4898 | OH | TYR | B | 287 | 2.471 | 58.617 | 28.340 | 1.00 | 30.28 | | O |
| ANISOU | 4898 | OH | TYR | B | 287 | 3098 | 3864 | 4544 | −123 | −77 | −481 | O |
| ATOM | 4899 | N | TYR | B | 288 | 10.184 | 54.353 | 27.703 | 1.00 | 26.50 | | N |
| ANISOU | 4899 | N | TYR | B | 288 | 1980 | 2930 | 5160 | −171 | 151 | −157 | N |
| ATOM | 4900 | CA | TYR | B | 288 | 11.233 | 53.353 | 27.776 | 1.00 | 29.11 | | C |
| ANISOU | 4900 | CA | TYR | B | 288 | 2208 | 3202 | 5651 | −158 | 181 | −111 | C |
| ATOM | 4901 | C | TYR | B | 288 | 11.908 | 53.410 | 29.139 | 1.00 | 36.77 | | C |
| ANISOU | 4901 | C | TYR | B | 288 | 3073 | 4102 | 6795 | −181 | −88 | −173 | C |
| ATOM | 4902 | O | TYR | B | 288 | 12.146 | 54.498 | 29.670 | 1.00 | 37.21 | | O |
| ANISOU | 4902 | O | TYR | B | 288 | 3057 | 4072 | 7008 | −208 | −242 | −204 | O |
| ATOM | 4903 | CB | TYR | B | 288 | 12.279 | 53.571 | 26.678 | 1.00 | 32.78 | | C |
| ANISOU | 4903 | CB | TYR | B | 288 | 2532 | 3538 | 6385 | −141 | 409 | 24 | C |
| ATOM | 4904 | CG | TYR | B | 288 | 11.850 | 53.155 | 25.293 | 1.00 | 33.66 | | C |
| ANISOU | 4904 | CG | TYR | B | 288 | 2780 | 3697 | 6313 | −92 | 688 | 96 | C |
| ATOM | 4905 | CD2 | TYR | B | 288 | 12.106 | 51.870 | 24.822 | 1.00 | 31.41 | | C |
| ANISOU | 4905 | CD2 | TYR | B | 288 | 2550 | 3432 | 5953 | −44 | 826 | 132 | C |
| ATOM | 4906 | CD1 | TYR | B | 288 | 11.202 | 54.046 | 24.448 | 1.00 | 32.00 | | C |
| ANISOU | 4906 | CD1 | TYR | B | 288 | 2663 | 3497 | 5999 | −86 | 802 | 125 | C |
| ATOM | 4907 | CE2 | TYR | B | 288 | 11.725 | 51.489 | 23.551 | 1.00 | 28.45 | | C |
| ANISOU | 4907 | CE2 | TYR | B | 288 | 2338 | 3081 | 5391 | 12 | 1062 | 189 | C |
| ATOM | 4908 | CE1 | TYR | B | 288 | 10.806 | 53.667 | 23.179 | 1.00 | 30.65 | | C |
| ANISOU | 4908 | CE1 | TYR | B | 288 | 2654 | 3353 | 5640 | −32 | 1032 | 186 | C |
| ATOM | 4909 | CZ | TYR | B | 288 | 11.067 | 52.391 | 22.742 | 1.00 | 34.15 | | C |
| ANISOU | 4909 | CZ | TYR | B | 288 | 3167 | 3810 | 5998 | 19 | 1155 | 214 | C |
| ATOM | 4910 | OH | TYR | B | 288 | 10.671 | 52.019 | 21.484 | 1.00 | 44.50 | | O |
| ANISOU | 4910 | OH | TYR | B | 288 | 4674 | 5130 | 7102 | 84 | 1362 | 265 | O |
| ATOM | 4911 | N | ILE | B | 289 | 12.199 | 52.246 | 29.718 | 1.00 | 37.18 | | N |
| ANISOU | 4911 | N | ILE | B | 289 | 3134 | 4180 | 6811 | −167 | −162 | −195 | N |
| ATOM | 4912 | CA | ILE | B | 289 | 13.072 | 52.191 | 30.894 | 1.00 | 34.07 | | C |
| ANISOU | 4912 | CA | ILE | B | 289 | 2635 | 3686 | 6623 | −180 | −417 | −235 | C |
| ATOM | 4913 | C | ILE | B | 289 | 14.229 | 51.227 | 30.643 | 1.00 | 33.65 | | C |
| ANISOU | 4913 | C | ILE | B | 289 | 2433 | 3549 | 6805 | −164 | −347 | −153 | C |
| ATOM | 4914 | O | ILE | B | 289 | 14.187 | 50.414 | 29.727 | 1.00 | 35.40 | | O |
| ANISOU | 4914 | O | ILE | B | 289 | 2684 | 3818 | 6950 | −133 | −112 | −88 | O |
| ATOM | 4915 | CB | ILE | B | 289 | 12.303 | 51.789 | 32.169 | 1.00 | 37.53 | | C |
| ANISOU | 4915 | CB | ILE | B | 289 | 3248 | 4222 | 6789 | −170 | −638 | −354 | C |
| ATOM | 4916 | CG1 | ILE | B | 289 | 11.698 | 50.387 | 32.028 | 1.00 | 36.00 | | C |
| ANISOU | 4916 | CG1 | ILE | B | 289 | 3183 | 4162 | 6334 | −145 | −532 | −352 | C |
| ATOM | 4917 | CG2 | ILE | B | 289 | 11.219 | 52.826 | 32.489 | 1.00 | 33.80 | | C |
| ANISOU | 4917 | CG2 | ILE | B | 289 | 2909 | 3813 | 6120 | −173 | −702 | −431 | C |
| ATOM | 4918 | CD1 | ILE | B | 289 | 11.106 | 49.861 | 33.323 | 1.00 | 27.84 | | C |
| ANISOU | 4918 | CD1 | ILE | B | 289 | 2304 | 3204 | 5071 | −129 | −727 | −443 | C |
| ATOM | 4919 | N | LYS | B | 290 | 15.274 | 51.314 | 31.448 | 1.00 | 42.24 | | N |
| ANISOU | 4919 | N | LYS | B | 290 | 3365 | 4498 | 8188 | −178 | −560 | −156 | N |
| ATOM | 4920 | CA | LYS | B | 290 | 16.433 | 50.469 | 31.221 | 1.00 | 43.33 | | C |
| ANISOU | 4920 | CA | LYS | B | 290 | 3341 | 4535 | 8586 | −157 | −495 | −68 | C |
| ATOM | 4921 | C | LYS | B | 290 | 16.403 | 49.289 | 32.189 | 1.00 | 40.42 | | C |
| ANISOU | 4921 | C | LYS | B | 290 | 3052 | 4218 | 8088 | −139 | −678 | −135 | C |
| ATOM | 4922 | O | LYS | B | 290 | 16.181 | 49.475 | 33.380 | 1.00 | 40.86 | | O |
| ANISOU | 4922 | O | LYS | B | 290 | 3197 | 4275 | 8053 | −150 | −966 | −233 | O |
| ATOM | 4923 | CB | LYS | B | 290 | 17.700 | 51.294 | 31.396 | 1.00 | 62.25 | | C |
| ANISOU | 4923 | CB | LYS | B | 290 | 5621 | 6719 | 11310 | −165 | −581 | −4 | C |
| ATOM | 4924 | CG | LYS | B | 290 | 18.683 | 51.211 | 30.241 | 1.00 | 81.29 | | C |
| ANISOU | 4924 | CG | LYS | B | 290 | 7902 | 9016 | 13969 | −139 | −297 | 149 | C |
| ATOM | 4925 | CD | LYS | B | 290 | 19.256 | 52.610 | 29.945 | 1.00 | 90.14 | | C |
| ANISOU | 4925 | CD | LYS | B | 290 | 8937 | 9979 | 15332 | −159 | −287 | 215 | C |
| ATOM | 4926 | CE | LYS | B | 290 | 19.778 | 52.719 | 28.521 | 1.00 | 94.52 | | C |
| ANISOU | 4926 | CE | LYS | B | 290 | 9420 | 10466 | 16026 | −125 | 70 | 368 | C |
| ATOM | 4927 | NZ | LYS | B | 290 | 18.651 | 52.529 | 27.566 | 1.00 | 97.30 | | N |
| ANISOU | 4927 | NZ | LYS | B | 290 | 9897 | 10991 | 16080 | −106 | 320 | 365 | N |
| ATOM | 4928 | N | VAL | B | 291 | 16.621 | 48.077 | 31.683 | 1.00 | 41.63 | | N |
| ANISOU | 4928 | N | VAL | B | 291 | 3205 | 4406 | 8206 | −102 | −509 | −80 | N |
| ATOM | 4929 | CA | VAL | B | 291 | 16.708 | 46.891 | 32.545 | 1.00 | 35.27 | | C |
| ANISOU | 4929 | CA | VAL | B | 291 | 2469 | 3631 | 7299 | −82 | −669 | −126 | C |
| ATOM | 4930 | C | VAL | B | 291 | 18.114 | 46.274 | 32.499 | 1.00 | 41.63 | | C |
| ANISOU | 4930 | C | VAL | B | 291 | 3070 | 4283 | 8466 | −58 | −670 | −41 | C |
| ATOM | 4931 | O | VAL | B | 291 | 18.608 | 45.932 | 31.423 | 1.00 | 43.17 | | O |
| ANISOU | 4931 | O | VAL | B | 291 | 3180 | 4440 | 8785 | −26 | −390 | 62 | O |
| ATOM | 4932 | CB | VAL | B | 291 | 15.670 | 45.834 | 32.147 | 1.00 | 32.91 | | C |
| ANISOU | 4932 | CB | VAL | B | 291 | 2385 | 3504 | 6616 | −56 | −505 | −146 | C |
| ATOM | 4933 | CG1 | VAL | B | 291 | 15.804 | 44.616 | 33.015 | 1.00 | 32.41 | | C |
| ANISOU | 4933 | CG1 | VAL | B | 291 | 2386 | 3460 | 6470 | −36 | −659 | −179 | C |
| ATOM | 4934 | CG2 | VAL | B | 291 | 14.266 | 46.394 | 32.276 | 1.00 | 27.50 | | C |
| ANISOU | 4934 | CG2 | VAL | B | 291 | 1902 | 2960 | 5588 | −76 | −515 | −222 | C |
| ATOM | 4935 | N | ARG | B | 292 | 18.751 | 46.144 | 33.666 | 1.00 | 43.77 | | N |
| ANISOU | 4935 | N | ARG | B | 292 | 3353 | 4456 | 8822 | −62 | −960 | −80 | N |
| ATOM | 4936 | CA | ARG | B | 292 | 20.141 | 45.680 | 33.765 | 1.00 | 49.08 | | C |
| ANISOU | 4936 | CA | ARG | B | 292 | 3898 | 4954 | 9795 | −44 | −987 | −2 | C |
| ATOM | 4937 | C | ARG | B | 292 | 20.288 | 44.148 | 33.872 | 1.00 | 53.45 | | C |
| ANISOU | 4937 | C | ARG | B | 292 | 4456 | 5550 | 10301 | −3 | −967 | 9 | C |
| ATOM | 4938 | O | ARG | B | 292 | 21.243 | 43.566 | 33.343 | 1.00 | 54.70 | | O |
| ANISOU | 4938 | O | ARG | B | 292 | 4492 | 5607 | 10685 | 25 | −822 | 102 | O |
| ATOM | 4939 | CB | ARG | B | 292 | 20.833 | 46.321 | 34.977 | 1.00 | 52.39 | | C |
| ANISOU | 4939 | CB | ARG | B | 292 | 4334 | 5214 | 10356 | −62 | −1324 | −47 | C |
| ATOM | 4940 | CG | ARG | B | 292 | 21.003 | 47.846 | 34.943 | 1.00 | 62.02 | | C |
| ANISOU | 4940 | CG | ARG | B | 292 | 5523 | 6331 | 11711 | −93 | −1375 | −44 | C |
| ATOM | 4941 | CD | ARG | B | 292 | 22.108 | 48.351 | 34.016 | 1.00 | 68.97 | | C |
| ANISOU | 4941 | CD | ARG | B | 292 | 6204 | 7038 | 12963 | −99 | −1183 | 92 | C |
| ATOM | 4942 | NE | ARG | B | 292 | 22.082 | 49.813 | 33.954 | 1.00 | 77.48 | | N |
| ANISOU | 4942 | NE | ARG | B | 292 | 7265 | 8037 | 14136 | −127 | −1229 | 91 | N |
| ATOM | 4943 | CZ | ARG | B | 292 | 22.441 | 50.542 | 32.897 | 1.00 | 86.21 | | C |
| ANISOU | 4943 | CZ | ARG | B | 292 | 8252 | 9069 | 15434 | −134 | −993 | 198 | C |
| ATOM | 4944 | NH1 | ARG | B | 292 | 22.881 | 49.951 | 31.793 | 1.00 | 91.60 | | N |
| ANISOU | 4944 | NH1 | ARG | B | 292 | 8837 | 9742 | 16224 | −108 | −679 | 317 | N |
| ATOM | 4945 | NH2 | ARG | B | 292 | 22.367 | 51.870 | 32.945 | 1.00 | 84.22 | | N |
| ANISOU | 4945 | NH2 | ARG | B | 292 | 7994 | 8744 | 15261 | −157 | −1067 | 189 | N |
| ATOM | 4946 | N | GLY | B | 293 | 19.367 | 43.500 | 34.582 | 1.00 | 48.09 | | N |
| ANISOU | 4946 | N | GLY | B | 293 | 3926 | 5010 | 9337 | 3 | −1117 | −83 | N |
| ATOM | 4947 | CA | GLY | B | 293 | 19.486 | 42.071 | 34.820 | 1.00 | 47.42 | | C |
| ANISOU | 4947 | CA | GLY | B | 293 | 3857 | 4954 | 9205 | 43 | −1141 | −77 | C |
| ATOM | 4948 | C | GLY | B | 293 | 18.157 | 41.354 | 34.960 | 1.00 | 45.26 | | C |
| ANISOU | 4948 | C | GLY | B | 293 | 3860 | 4874 | 8463 | 49 | −1088 | −142 | C |
| ATOM | 4949 | O | GLY | B | 293 | 17.126 | 41.982 | 35.208 | 1.00 | 39.92 | | O |
| ANISOU | 4949 | O | GLY | B | 293 | 3348 | 4304 | 7515 | 22 | −1117 | −208 | O |
| ATOM | 4950 | N | LEU | B | 294 | 18.177 | 40.035 | 34.778 | 1.00 | 44.65 | | N |
| ANISOU | 4950 | N | LEU | B | 294 | 3835 | 4831 | 8299 | 85 | −997 | −116 | N |
| ATOM | 4951 | CA | LEU | B | 294 | 16.985 | 39.208 | 34.974 | 1.00 | 41.08 | | C |
| ANISOU | 4951 | CA | LEU | B | 294 | 3637 | 4537 | 7434 | 86 | −962 | −163 | C |
| ATOM | 4952 | C | LEU | B | 294 | 17.400 | 37.879 | 35.613 | 1.00 | 49.16 | | C |
| ANISOU | 4952 | C | LEU | B | 294 | 4693 | 5527 | 8459 | 120 | −1084 | −155 | C |
| ATOM | 4953 | O | LEU | B | 294 | 18.020 | 37.030 | 34.970 | 1.00 | 56.60 | | O |
| ANISOU | 4953 | O | LEU | B | 294 | 5543 | 6416 | 9548 | 158 | −942 | −93 | O |
| ATOM | 4954 | CB | LEU | B | 294 | 16.240 | 38.978 | 33.654 | 1.00 | 42.68 | | C |
| ANISOU | 4954 | CB | LEU | B | 294 | 3916 | 4839 | 7460 | 93 | −641 | −133 | C |
| ATOM | 4955 | CG | LEU | B | 294 | 14.716 | 38.738 | 33.723 | 1.00 | 50.41 | | C |
| ANISOU | 4955 | CG | LEU | B | 294 | 5139 | 5985 | 8031 | 68 | −605 | −186 | C |
| ATOM | 4956 | CD1 | LEU | B | 294 | 14.058 | 38.643 | 32.349 | 1.00 | 46.88 | | C |
| ANISOU | 4956 | CD1 | LEU | B | 294 | 4760 | 5603 | 7450 | 75 | −328 | −158 | C |
| ATOM | 4957 | CD2 | LEU | B | 294 | 14.367 | 37.498 | 34.518 | 1.00 | 57.12 | | C |
| ANISOU | 4957 | CD2 | LEU | B | 294 | 6124 | 6879 | 8699 | 78 | −719 | −204 | C |
| ATOM | 4958 | N | ASP | B | 295 | 17.072 | 37.714 | 36.890 | 1.00 | 47.77 | | N |
| ANISOU | 4958 | N | ASP | B | 295 | 4661 | 5374 | 8117 | 114 | −1342 | −214 | N |
| ATOM | 4959 | CA | ASP | B | 295 | 17.496 | 36.543 | 37.634 | 1.00 | 43.22 | | C |
| ANISOU | 4959 | CA | ASP | B | 295 | 4127 | 4751 | 7543 | 147 | −1497 | −205 | C |
| ATOM | 4960 | C | ASP | B | 295 | 16.365 | 35.537 | 37.816 | 1.00 | 42.84 | | C |
| ANISOU | 4960 | C | ASP | B | 295 | 4314 | 4842 | 7120 | 149 | −1425 | −219 | C |
| ATOM | 4961 | O | ASP | B | 295 | 15.198 | 35.904 | 37.966 | 1.00 | 33.68 | | O |
| ANISOU | 4961 | O | ASP | B | 295 | 3318 | 3804 | 5674 | 123 | −1380 | −257 | O |
| ATOM | 4962 | CB | ASP | B | 295 | 18.038 | 36.938 | 39.008 | 1.00 | 54.06 | | C |
| ANISOU | 4962 | CB | ASP | B | 295 | 5518 | 6021 | 9001 | 155 | −1863 | −251 | C |
| ATOM | 4963 | CG | ASP | B | 295 | 19.217 | 37.888 | 38.922 | 1.00 | 70.48 | | C |
| ANISOU | 4963 | CG | ASP | B | 295 | 7345 | 7932 | 11503 | 146 | −1986 | −232 | C |
| ATOM | 4964 | OD1 | ASP | B | 295 | 19.665 | 38.190 | 37.797 | 1.00 | 77.69 | | O |
| ANISOU | 4964 | OD1 | ASP | B | 295 | 8054 | 8809 | 12656 | 139 | −1756 | −169 | O |
| ATOM | 4965 | OD2 | ASP | B | 295 | 19.708 | 38.321 | 39.985 | 1.00 | 76.02 | | O |
| ANISOU | 4965 | OD2 | ASP | B | 295 | 8106 | 8523 | 12256 | 148 | −2264 | −272 | O |
| ATOM | 4966 | N | MET | B | 296 | 16.742 | 34.263 | 37.809 | 1.00 | 39.80 | | N |
| ANISOU | 4966 | N | MET | B | 296 | 3930 | 4423 | 6768 | 180 | −1416 | −181 | N |
| ATOM | 4967 | CA | MET | B | 296 | 15.879 | 33.172 | 38.210 | 1.00 | 29.61 | | C |
| ANISOU | 4967 | CA | MET | B | 296 | 2847 | 3224 | 5181 | 182 | −1409 | −183 | C |
| ATOM | 4968 | C | MET | B | 296 | 16.749 | 32.179 | 38.996 | 1.00 | 38.78 | | C |
| ANISOU | 4968 | C | MET | B | 296 | 3993 | 4278 | 6462 | 224 | −1605 | −160 | C |
| ATOM | 4969 | O | MET | B | 296 | 17.825 | 31.801 | 38.530 | 1.00 | 38.16 | | O |
| ANISOU | 4969 | O | MET | B | 296 | 3733 | 4088 | 6680 | 256 | −1581 | −118 | O |
| ATOM | 4970 | CB | MET | B | 296 | 15.226 | 32.511 | 36.992 | 1.00 | 28.37 | | C |
| ANISOU | 4970 | CB | MET | B | 296 | 2726 | 3145 | 4908 | 175 | −1126 | −153 | C |
| ATOM | 4971 | CG | MET | B | 296 | 14.177 | 31.466 | 37.358 | 1.00 | 40.85 | | C |
| ANISOU | 4971 | CG | MET | B | 296 | 4511 | 4816 | 6192 | 162 | −1116 | −149 | C |
| ATOM | 4972 | SD | MET | B | 296 | 13.283 | 30.825 | 35.928 | 1.00 | 39.81 | | S |
| ANISOU | 4972 | SD | MET | B | 296 | 4445 | 4759 | 5921 | 146 | −836 | −128 | S |
| ATOM | 4973 | CE | MET | B | 296 | 14.521 | 31.120 | 34.695 | 1.00 | 58.36 | | C |
| ANISOU | 4973 | CE | MET | B | 296 | 6594 | 6999 | 8580 | 194 | −676 | −102 | C |
| ATOM | 4974 | N | PHE | B | 297 | 16.289 | 31.784 | 40.184 | 1.00 | 31.20 | | N |
| ANISOU | 4974 | N | PHE | B | 297 | 3228 | 3346 | 5281 | 232 | −1791 | −180 | N |
| ATOM | 4975 | CA | PHE | B | 297 | 17.053 | 30.932 | 41.086 | 1.00 | 32.67 | | C |
| ANISOU | 4975 | CA | PHE | B | 297 | 3438 | 3426 | 5549 | 275 | −2019 | −162 | C |
| ATOM | 4976 | C | PHE | B | 297 | 18.480 | 31.442 | 41.299 | 1.00 | 40.36 | | C |
| ANISOU | 4976 | C | PHE | B | 297 | 4198 | 4228 | 6908 | 299 | −2225 | −162 | C |
| ATOM | 4977 | O | PHE | B | 297 | 19.415 | 30.654 | 41.451 | 1.00 | 42.55 | | O |
| ANISOU | 4977 | O | PHE | B | 297 | 4377 | 4390 | 7401 | 336 | −2330 | −123 | O |
| ATOM | 4978 | CB | PHE | B | 297 | 17.071 | 29.492 | 40.555 | 1.00 | 32.39 | | C |
| ANISOU | 4978 | CB | PHE | B | 297 | 3406 | 3394 | 5506 | 292 | −1880 | −108 | C |
| ATOM | 4979 | CG | PHE | B | 297 | 15.704 | 28.881 | 40.458 | 1.00 | 36.65 | | C |
| ANISOU | 4979 | CG | PHE | B | 297 | 4149 | 4073 | 5705 | 263 | −1727 | −99 | C |
| ATOM | 4980 | CD1 | PHE | B | 297 | 14.820 | 28.962 | 41.526 | 1.00 | 30.76 | | C |
| ANISOU | 4980 | CD1 | PHE | B | 297 | 3619 | 3397 | 4671 | 256 | −1830 | −113 | C |
| ATOM | 4981 | CD2 | PHE | B | 297 | 15.283 | 28.268 | 39.292 | 1.00 | 29.88 | | C |
| ANISOU | 4981 | CD2 | PHE | B | 297 | 3269 | 3264 | 4819 | 248 | −1478 | −74 | C |
| ATOM | 4982 | CE1 | PHE | B | 297 | 13.548 | 28.422 | 41.440 | 1.00 | 29.62 | | C |
| ANISOU | 4982 | CE1 | PHE | B | 297 | 3630 | 3368 | 4257 | 226 | −1680 | −88 | C |
| ATOM | 4983 | CE2 | PHE | B | 297 | 14.021 | 27.721 | 39.202 | 1.00 | 34.96 | | C |
| ANISOU | 4983 | CE2 | PHE | B | 297 | 4080 | 4014 | 5188 | 214 | −1367 | −61 | C |
| ATOM | 4984 | CZ | PHE | B | 297 | 13.149 | 27.803 | 40.276 | 1.00 | 37.61 | | C |
| ANISOU | 4984 | CZ | PHE | B | 297 | 4593 | 4419 | 5276 | 197 | −1462 | −62 | C |
| ATOM | 4985 | N | GLY | B | 298 | 18.645 | 32.763 | 41.300 | 1.00 | 38.83 | | N |
| ANISOU | 4985 | N | GLY | B | 298 | 3922 | 4007 | 6824 | 276 | −2287 | −199 | N |
| ATOM | 4986 | CA | GLY | B | 298 | 19.930 | 33.372 | 41.605 | 1.00 | 38.55 | | C |
| ANISOU | 4986 | CA | GLY | B | 298 | 3681 | 3792 | 7174 | 289 | −2521 | −198 | C |
| ATOM | 4987 | C | GLY | B | 298 | 20.915 | 33.505 | 40.456 | 1.00 | 47.56 | | C |
| ANISOU | 4987 | C | GLY | B | 298 | 4499 | 4838 | 8733 | 289 | −2345 | −132 | C |
| ATOM | 4988 | O | GLY | B | 298 | 22.011 | 34.005 | 40.652 | 1.00 | 58.40 | | O |
| ANISOU | 4988 | O | GLY | B | 298 | 5751 | 6049 | 10389 | 274 | −2431 | −116 | O |
| ATOM | 4989 | N | THR | B | 299 | 20.530 | 33.076 | 39.258 | 1.00 | 51.70 | | N |
| ANISOU | 4989 | N | THR | B | 299 | 4990 | 5452 | 9200 | 288 | −1995 | −91 | N |
| ATOM | 4990 | CA | THR | B | 299 | 21.393 | 33.186 | 38.085 | 1.00 | 51.75 | | C |
| ANISOU | 4990 | CA | THR | B | 299 | 4725 | 5372 | 9564 | 307 | −1768 | −19 | C |
| ATOM | 4991 | C | THR | B | 299 | 20.997 | 34.362 | 37.208 | 1.00 | 51.27 | | C |
| ANISOU | 4991 | C | THR | B | 299 | 4608 | 5369 | 9501 | 271 | −1556 | −21 | C |
| ATOM | 4992 | O | THR | B | 299 | 19.829 | 34.459 | 36.809 | 1.00 | 49.60 | | O |
| ANISOU | 4992 | O | THR | B | 299 | 4581 | 5314 | 8950 | 246 | −1390 | −55 | O |
| ATOM | 4993 | CB | THR | B | 299 | 21.338 | 31.924 | 37.211 | 1.00 | 55.20 | | C |
| ANISOU | 4993 | CB | THR | B | 299 | 5182 | 5842 | 9948 | 353 | −1502 | 31 | C |
| ATOM | 4994 | OG1 | THR | B | 299 | 21.301 | 30.751 | 38.035 | 1.00 | 62.24 | | O |
| ANISOU | 4994 | OG1 | THR | B | 299 | 6207 | 6728 | 10715 | 378 | −1675 | 23 | O |
| ATOM | 4995 | CG2 | THR | B | 299 | 22.541 | 31.877 | 36.282 | 1.00 | 53.99 | | C |
| ANISOU | 4995 | CG2 | THR | B | 299 | 4741 | 5548 | 10224 | 405 | −1319 | 119 | C |
| ATOM | 4996 | N | ASN | B | 300 | 21.957 | 35.235 | 36.889 | 1.00 | 47.70 | | N |
| ANISOU | 4996 | N | ASN | B | 300 | 3904 | 4784 | 9437 | 266 | −1556 | 23 | N |
| ATOM | 4997 | CA | ASN | B | 300 | 21.698 | 36.333 | 35.952 | 1.00 | 45.21 | | C |
| ANISOU | 4997 | CA | ASN | B | 300 | 3511 | 4503 | 9165 | 239 | −1332 | 40 | C |
| ATOM | 4998 | C | ASN | B | 300 | 21.724 | 35.840 | 34.510 | 1.00 | 45.21 | | C |
| ANISOU | 4998 | C | ASN | B | 300 | 3461 | 4530 | 9187 | 285 | −929 | 114 | C |
| ATOM | 4999 | O | ASN | B | 300 | 22.738 | 35.323 | 34.040 | 1.00 | 49.80 | | O |
| ANISOU | 4999 | O | ASN | B | 300 | 3876 | 4990 | 10056 | 335 | −807 | 196 | O |
| ATOM | 5000 | CB | ASN | B | 300 | 22.705 | 37.471 | 36.128 | 1.00 | 46.19 | | C |
| ANISOU | 5000 | CB | ASN | B | 300 | 3526 | 4463 | 9563 | 190 | −1405 | 67 | C |
| ATOM | 5001 | CG | ASN | B | 300 | 22.353 | 38.724 | 35.292 | 1.00 | 52.39 | | C |
| ANISOU | 5001 | CG | ASN | B | 300 | 4264 | 5282 | 10359 | 158 | −1211 | 81 | C |
| ATOM | 5002 | OD1 | ASN | B | 300 | 21.244 | 38.855 | 34.742 | 1.00 | 40.56 | | O |
| ANISOU | 5002 | OD1 | ASN | B | 300 | 2839 | 3944 | 8630 | 162 | −1063 | 51 | O |
| ATOM | 5003 | ND2 | ASN | B | 300 | 23.311 | 39.651 | 35.204 | 1.00 | 58.21 | | N |
| ANISOU | 5003 | ND2 | ASN | B | 300 | 4880 | 5857 | 11382 | 124 | −1219 | 131 | N |
| ATOM | 5004 | N | MET | B | 301 | 20.593 | 35.993 | 33.826 | 1.00 | 39.37 | | N |
| ANISOU | 5004 | N | MET | B | 301 | 2912 | 3942 | 8105 | 269 | −721 | 83 | N |
| ATOM | 5005 | CA | MET | B | 301 | 20.424 | 35.483 | 32.472 | 1.00 | 46.34 | | C |
| ANISOU | 5005 | CA | MET | B | 301 | 3835 | 4858 | 8915 | 320 | −361 | 134 | C |
| ATOM | 5006 | C | MET | B | 301 | 20.822 | 36.493 | 31.398 | 1.00 | 54.07 | | C |
| ANISOU | 5006 | C | MET | B | 301 | 4665 | 5779 | 10102 | 334 | −110 | 203 | C |
| ATOM | 5007 | O | MET | B | 301 | 21.027 | 36.118 | 30.240 | 1.00 | 55.18 | | O |
| ANISOU | 5007 | O | MET | B | 301 | 4804 | 5894 | 10268 | 403 | 202 | 268 | O |
| ATOM | 5008 | CB | MET | B | 301 | 18.976 | 35.074 | 32.238 | 1.00 | 47.30 | | C |
| ANISOU | 5008 | CB | MET | B | 301 | 4248 | 5153 | 8569 | 298 | −287 | 70 | C |
| ATOM | 5009 | CG | MET | B | 301 | 18.309 | 34.361 | 33.383 | 1.00 | 46.87 | | C |
| ANISOU | 5009 | CG | MET | B | 301 | 4366 | 5177 | 8264 | 267 | −531 | 4 | C |
| ATOM | 5010 | SD | MET | B | 301 | 18.330 | 32.587 | 33.193 | 1.00 | 70.07 | | S |
| ANISOU | 5010 | SD | MET | B | 301 | 7410 | 8111 | 11102 | 323 | −462 | 24 | S |
| ATOM | 5011 | CE | MET | B | 301 | 19.976 | 32.203 | 33.782 | 1.00 | 94.09 | | C |
| ANISOU | 5011 | CE | MET | B | 301 | 10201 | 10967 | 14582 | 374 | −614 | 80 | C |
| ATOM | 5012 | N | MET | B | 302 | 20.900 | 37.773 | 31.762 | 1.00 | 55.49 | | N |
| ANISOU | 5012 | N | MET | B | 302 | 4742 | 5930 | 10411 | 277 | −236 | 191 | N |
| ATOM | 5013 | CA | MET | B | 302 | 21.338 | 38.778 | 30.802 | 1.00 | 56.74 | | C |
| ANISOU | 5013 | CA | MET | B | 302 | 4751 | 6017 | 10791 | 284 | −6 | 270 | C |
| ATOM | 5014 | C | MET | B | 302 | 22.849 | 38.710 | 30.681 | 1.00 | 65.24 | | C |
| ANISOU | 5014 | C | MET | B | 302 | 5678 | 6900 | 12209 | 291 | 38 | 370 | C |
| ATOM | 5015 | O | MET | B | 302 | 23.576 | 39.037 | 31.618 | 1.00 | 65.55 | | O |
| ANISOU | 5015 | O | MET | B | 302 | 5634 | 6827 | 12444 | 240 | −226 | 362 | O |
| ATOM | 5016 | CB | MET | B | 302 | 20.891 | 40.174 | 31.229 | 1.00 | 61.10 | | C |
| ANISOU | 5016 | CB | MET | B | 302 | 5316 | 6596 | 11302 | 203 | −161 | 220 | C |
| ATOM | 5017 | CG | MET | B | 302 | 19.388 | 40.378 | 31.151 | 1.00 | 60.26 | | C |
| ANISOU | 5017 | CG | MET | B | 302 | 5470 | 6677 | 10748 | 171 | −144 | 131 | C |
| ATOM | 5018 | SD | MET | B | 302 | 18.883 | 42.095 | 31.379 | 1.00 | 75.22 | | S |
| ANISOU | 5018 | SD | MET | B | 302 | 7357 | 8592 | 12630 | 99 | −251 | 87 | S |
| ATOM | 5019 | CE | MET | B | 302 | 19.882 | 42.910 | 30.138 | 1.00 | 43.50 | | C |
| ANISOU | 5019 | CE | MET | B | 302 | 3131 | 4428 | 8968 | 123 | 42 | 223 | C |
| ATOM | 5020 | N | SER | B | 303 | 23.327 | 38.282 | 29.521 | 1.00 | 81.01 | | N |
| ANISOU | 5020 | N | SER | B | 303 | 7658 | 8847 | 14275 | 359 | 374 | 465 | N |
| ATOM | 5021 | CA | SER | B | 303 | 24.759 | 38.121 | 29.338 | 1.00 | 95.67 | | C |
| ANISOU | 5021 | CA | SER | B | 303 | 9364 | 10518 | 16469 | 369 | 445 | 573 | C |
| ATOM | 5022 | C | SER | B | 303 | 25.317 | 39.482 | 28.953 | 1.00 | 99.04 | | C |
| ANISOU | 5022 | C | SER | B | 303 | 9696 | 10829 | 17104 | 320 | 516 | 647 | C |
| ATOM | 5023 | O | SER | B | 303 | 26.488 | 39.771 | 29.181 | 1.00 | 104.18 | | O |
| ANISOU | 5023 | O | SER | B | 303 | 10190 | 11299 | 18095 | 292 | 455 | 723 | O |
| ATOM | 5024 | CB | SER | B | 303 | 25.079 | 37.035 | 28.306 | 1.00 | 103.63 | | C |
| ANISOU | 5024 | CB | SER | B | 303 | 10414 | 11508 | 17453 | 472 | 771 | 646 | C |
| ATOM | 5025 | OG | SER | B | 303 | 24.042 | 36.904 | 27.348 | 1.00 | 108.58 | | O |
| ANISOU | 5025 | OG | SER | B | 303 | 11228 | 12265 | 17761 | 533 | 1019 | 621 | O |
| ATOM | 5026 | N | SER | B | 304 | 24.466 | 40.344 | 28.407 | 1.00 | 101.50 | | N |
| ANISOU | 5026 | N | SER | B | 304 | 10102 | 11236 | 17227 | 308 | 628 | 627 | N |
| ATOM | 5027 | CA | SER | B | 304 | 24.926 | 41.676 | 28.041 | 1.00 | 105.43 | | C |
| ANISOU | 5027 | CA | SER | B | 304 | 10521 | 11623 | 17916 | 267 | 687 | 698 | C |
| ATOM | 5028 | C | SER | B | 304 | 24.494 | 42.646 | 29.143 | 1.00 | 104.93 | | C |
| ANISOU | 5028 | C | SER | B | 304 | 10450 | 11582 | 17838 | 181 | 342 | 599 | C |
| ATOM | 5029 | O | SER | B | 304 | 23.368 | 42.578 | 29.640 | 1.00 | 104.28 | | O |
| ANISOU | 5029 | O | SER | B | 304 | 10487 | 11663 | 17470 | 165 | 201 | 484 | O |
| ATOM | 5030 | CB | SER | B | 304 | 24.363 | 42.086 | 26.674 | 1.00 | 104.43 | | C |
| ANISOU | 5030 | CB | SER | B | 304 | 10516 | 11559 | 17603 | 316 | 1037 | 751 | C |
| ATOM | 5031 | OG | SER | B | 304 | 24.163 | 43.482 | 26.599 | 1.00 | 103.68 | | O |
| ANISOU | 5031 | OG | SER | B | 304 | 10402 | 11440 | 17550 | 263 | 1002 | 759 | O |
| ATOM | 5032 | N | SER | B | 305 | 25.399 | 43.560 | 29.489 | 1.00 | 104.30 | | N |
| ANISOU | 5032 | N | SER | B | 305 | 10237 | 11322 | 18070 | 134 | 217 | 650 | N |
| ATOM | 5033 | CA | SER | B | 305 | 25.270 | 44.421 | 30.670 | 1.00 | 103.37 | | C |
| ANISOU | 5033 | CA | SER | B | 305 | 10117 | 11170 | 17990 | 65 | −149 | 559 | C |
| ATOM | 5034 | C | SER | B | 305 | 24.792 | 45.830 | 30.310 | 1.00 | 103.18 | | C |
| ANISOU | 5034 | C | SER | B | 305 | 10117 | 11156 | 17929 | 34 | −106 | 558 | C |
| ATOM | 5035 | O | SER | B | 305 | 24.148 | 46.510 | 31.132 | 1.00 | 100.80 | | O |
| ANISOU | 5035 | O | SER | B | 305 | 9892 | 10910 | 17497 | −9 | −360 | 450 | O |
| ATOM | 5036 | CB | SER | B | 305 | 26.590 | 44.475 | 31.459 | 1.00 | 101.52 | | C |
| ANISOU | 5036 | CB | SER | B | 305 | 9734 | 10703 | 18136 | 39 | −377 | 600 | C |
| ATOM | 5037 | OG | SER | B | 305 | 27.150 | 43.176 | 31.634 | 1.00 | 99.75 | | O |
| ANISOU | 5037 | OG | SER | B | 305 | 9468 | 10450 | 17984 | 71 | −376 | 623 | O |
| ATOM | 5038 | N | LYS | B | 306 | 25.202 | 46.304 | 29.132 | 1.00 | 100.68 | | N |
| ANISOU | 5038 | N | LYS | B | 306 | 9741 | 10764 | 17749 | 59 | 203 | 683 | N |
| ATOM | 5039 | CA | LYS | B | 306 | 24.560 | 47.473 | 28.543 | 1.00 | 97.35 | | C |
| ANISOU | 5039 | CA | LYS | B | 306 | 9374 | 10389 | 17226 | 45 | 312 | 688 | C |
| ATOM | 5040 | C | LYS | B | 306 | 23.059 | 47.283 | 28.743 | 1.00 | 97.02 | | C |
| ANISOU | 5040 | C | LYS | B | 306 | 9507 | 10589 | 16766 | 36 | 258 | 555 | C |
| ATOM | 5041 | O | LYS | B | 306 | 22.507 | 46.248 | 28.364 | 1.00 | 89.54 | | O |
| ANISOU | 5041 | O | LYS | B | 306 | 8651 | 9776 | 15593 | 80 | 400 | 535 | O |
| ATOM | 5042 | CB | LYS | B | 306 | 24.905 | 47.598 | 27.060 | 1.00 | 92.21 | | C |
| ANISOU | 5042 | CB | LYS | B | 306 | 8713 | 9684 | 16640 | 102 | 718 | 835 | C |
| ATOM | 5043 | CG | LYS | B | 306 | 24.989 | 49.023 | 26.519 | 1.00 | 90.54 | | C |
| ANISOU | 5043 | CG | LYS | B | 306 | 8466 | 9382 | 16554 | 87 | 805 | 904 | C |
| ATOM | 5044 | CD | LYS | B | 306 | 26.449 | 49.346 | 26.235 | 1.00 | 93.87 | | C |
| ANISOU | 5044 | CD | LYS | B | 306 | 8701 | 9543 | 17422 | 102 | 890 | 1061 | C |
| ATOM | 5045 | CE | LYS | B | 306 | 26.618 | 50.494 | 25.255 | 1.00 | 92.29 | | C |
| ANISOU | 5045 | CE | LYS | B | 306 | 8478 | 9246 | 17341 | 125 | 1115 | 1179 | C |
| ATOM | 5046 | NZ | LYS | B | 306 | 28.043 | 50.588 | 24.813 | 1.00 | 93.83 | | N |
| ANISOU | 5046 | NZ | LYS | B | 306 | 8495 | 9185 | 17970 | 161 | 1266 | 1357 | N |
| ATOM | 5047 | N | GLY | B | 307 | 22.398 | 48.272 | 29.333 | 1.00 | 100.62 | | N |
| ANISOU | 5047 | N | GLY | B | 307 | 10011 | 11091 | 17129 | −15 | 56 | 468 | N |
| ATOM | 5048 | CA | GLY | B | 307 | 20.976 | 48.152 | 29.589 | 1.00 | 98.77 | | C |
| ANISOU | 5048 | CA | GLY | B | 307 | 9930 | 11071 | 16527 | −28 | −6 | 346 | C |
| ATOM | 5049 | C | GLY | B | 307 | 20.097 | 47.818 | 28.401 | 1.00 | 95.43 | | C |
| ANISOU | 5049 | C | GLY | B | 307 | 9612 | 10794 | 15854 | 12 | 314 | 372 | C |
| ATOM | 5050 | O | GLY | B | 307 | 20.336 | 48.269 | 27.277 | 1.00 | 104.24 | | O |
| ANISOU | 5050 | O | GLY | B | 307 | 10722 | 11856 | 17028 | 42 | 586 | 474 | O |
| ATOM | 5051 | N | LEU | B | 308 | 19.077 | 47.006 | 28.662 | 1.00 | 74.28 | | N |
| ANISOU | 5051 | N | LEU | B | 308 | 7044 | 8287 | 12891 | 21 | 276 | 281 | N |
| ATOM | 5052 | CA | LEU | B | 308 | 18.057 | 46.709 | 27.676 | 1.00 | 55.65 | | C |
| ANISOU | 5052 | CA | LEU | B | 308 | 4813 | 6067 | 10263 | 57 | 532 | 280 | C |
| ATOM | 5053 | C | LEU | B | 308 | 17.041 | 47.854 | 27.724 | 1.00 | 49.30 | | C |
| ANISOU | 5053 | C | LEU | B | 308 | 4101 | 5344 | 9285 | 6 | 465 | 217 | C |
| ATOM | 5054 | O | LEU | B | 308 | 16.531 | 48.184 | 28.797 | 1.00 | 44.10 | | O |
| ANISOU | 5054 | O | LEU | B | 308 | 3499 | 4739 | 8519 | −44 | 185 | 112 | O |
| ATOM | 5055 | CB | LEU | B | 308 | 17.418 | 45.352 | 27.969 | 1.00 | 50.50 | | C |
| ANISOU | 5055 | CB | LEU | B | 308 | 4330 | 5540 | 9316 | 83 | 488 | 209 | C |
| ATOM | 5056 | CG | LEU | B | 308 | 16.907 | 44.492 | 26.814 | 1.00 | 49.68 | | C |
| ANISOU | 5056 | CG | LEU | B | 308 | 4418 | 5508 | 8949 | 150 | 769 | 238 | C |
| ATOM | 5057 | CD1 | LEU | B | 308 | 17.898 | 44.450 | 25.672 | 1.00 | 53.57 | | C |
| ANISOU | 5057 | CD1 | LEU | B | 308 | 4793 | 5871 | 9689 | 229 | 1092 | 375 | C |
| ATOM | 5058 | CD2 | LEU | B | 308 | 16.693 | 43.085 | 27.335 | 1.00 | 43.77 | | C |
| ANISOU | 5058 | CD2 | LEU | B | 308 | 3776 | 4824 | 8029 | 168 | 668 | 182 | C |
| ATOM | 5059 | N | GLU | B | 309 | 16.763 | 48.473 | 26.580 | 1.00 | 43.74 | | N |
| ANISOU | 5059 | N | GLU | B | 309 | 3447 | 4642 | 8530 | 27 | 719 | 283 | N |
| ATOM | 5060 | CA | GLU | B | 309 | 15.797 | 49.569 | 26.543 | 1.00 | 43.53 | | C |
| ANISOU | 5060 | CA | GLU | B | 309 | 3532 | 4685 | 8324 | −16 | 662 | 229 | C |
| ATOM | 5061 | C | GLU | B | 309 | 14.426 | 49.008 | 26.224 | 1.00 | 38.92 | | C |
| ANISOU | 5061 | C | GLU | B | 309 | 3227 | 4273 | 7286 | −1 | 702 | 156 | C |
| ATOM | 5062 | O | GLU | B | 309 | 14.163 | 48.595 | 25.092 | 1.00 | 42.21 | | O |
| ANISOU | 5062 | O | GLU | B | 309 | 3772 | 4714 | 7553 | 53 | 945 | 208 | O |
| ATOM | 5063 | CB | GLU | B | 309 | 16.196 | 50.625 | 25.509 | 1.00 | 48.82 | | C |
| ANISOU | 5063 | CB | GLU | B | 309 | 4120 | 5252 | 9178 | −3 | 890 | 343 | C |
| ATOM | 5064 | CG | GLU | B | 309 | 15.837 | 52.031 | 25.908 | 1.00 | 63.43 | | C |
| ANISOU | 5064 | CG | GLU | B | 309 | 5937 | 7084 | 11080 | −67 | 733 | 303 | C |
| ATOM | 5065 | CD | GLU | B | 309 | 16.691 | 53.071 | 25.204 | 1.00 | 78.14 | | C |
| ANISOU | 5065 | CD | GLU | B | 309 | 7727 | 8784 | 13179 | −57 | 865 | 424 | C |
| ATOM | 5066 | OE1 | GLU | B | 309 | 17.907 | 52.833 | 25.074 | 1.00 | 84.67 | | O |
| ANISOU | 5066 | OE1 | GLU | B | 309 | 8452 | 9466 | 14251 | −30 | 920 | 516 | O |
| ATOM | 5067 | OE2 | GLU | B | 309 | 16.156 | 54.135 | 24.803 | 1.00 | 79.98 | | O |
| ANISOU | 5067 | OE2 | GLU | B | 309 | 7997 | 9023 | 13369 | −77 | 908 | 432 | O |
| ATOM | 5068 | N | MET | B | 310 | 13.553 | 48.974 | 27.224 | 1.00 | 30.52 | | N |
| ANISOU | 5068 | N | MET | B | 310 | 2267 | 3316 | 6012 | −43 | 462 | 39 | N |
| ATOM | 5069 | CA | MET | B | 310 | 12.280 | 48.267 | 27.073 | 1.00 | 27.72 | | C |
| ANISOU | 5069 | CA | MET | B | 310 | 2145 | 3114 | 5275 | −34 | 474 | −22 | C |
| ATOM | 5070 | C | MET | B | 310 | 11.108 | 49.231 | 27.102 | 1.00 | 29.75 | | C |
| ANISOU | 5070 | C | MET | B | 310 | 2512 | 3453 | 5338 | −66 | 416 | −78 | C |
| ATOM | 5071 | O | MET | B | 310 | 11.008 | 50.108 | 27.976 | 1.00 | 26.25 | | O |
| ANISOU | 5071 | O | MET | B | 310 | 2017 | 3001 | 4956 | −103 | 236 | −133 | O |
| ATOM | 5072 | CB | MET | B | 310 | 12.116 | 47.204 | 28.152 | 1.00 | 25.03 | | C |
| ANISOU | 5072 | CB | MET | B | 310 | 1848 | 2834 | 4826 | −43 | 289 | −92 | C |
| ATOM | 5073 | CG | MET | B | 310 | 13.278 | 46.195 | 28.204 | 1.00 | 26.11 | | C |
| ANISOU | 5073 | CG | MET | B | 310 | 1871 | 2884 | 5164 | −8 | 323 | −40 | C |
| ATOM | 5074 | SD | MET | B | 310 | 12.962 | 44.732 | 29.240 | 1.00 | 32.67 | | S |
| ANISOU | 5074 | SD | MET | B | 310 | 2803 | 3795 | 5815 | −7 | 148 | −107 | S |
| ATOM | 5075 | CE | MET | B | 310 | 11.622 | 43.968 | 28.336 | 1.00 | 28.49 | | C |
| ANISOU | 5075 | CE | MET | B | 310 | 2515 | 3395 | 4916 | 8 | 301 | −120 | C |
| ATOM | 5076 | N | LEU | B | 311 | 10.235 | 49.076 | 26.114 | 1.00 | 27.82 | | N |
| ANISOU | 5076 | N | LEU | B | 311 | 2429 | 3276 | 4866 | −45 | 563 | −64 | N |
| ATOM | 5077 | CA | LEU | B | 311 | 9.047 | 49.893 | 26.030 | 1.00 | 28.16 | | C |
| ANISOU | 5077 | CA | LEU | B | 311 | 2579 | 3396 | 4725 | −68 | 518 | −109 | C |
| ATOM | 5078 | C | LEU | B | 311 | 8.053 | 49.438 | 27.080 | 1.00 | 33.42 | | C |
| ANISOU | 5078 | C | LEU | B | 311 | 3330 | 4178 | 5189 | −95 | 334 | −201 | C |
| ATOM | 5079 | O | LEU | B | 311 | 7.773 | 48.241 | 27.204 | 1.00 | 30.75 | | O |
| ANISOU | 5079 | O | LEU | B | 311 | 3069 | 3895 | 4721 | −86 | 326 | −214 | O |
| ATOM | 5080 | CB | LEU | B | 311 | 8.443 | 49.808 | 24.638 | 1.00 | 27.28 | | C |
| ANISOU | 5080 | CB | LEU | B | 311 | 2621 | 3300 | 4442 | −33 | 705 | −62 | C |
| ATOM | 5081 | CG | LEU | B | 311 | 7.257 | 50.747 | 24.401 | 1.00 | 27.02 | | C |
| ANISOU | 5081 | CG | LEU | B | 311 | 2684 | 3327 | 4255 | −53 | 664 | −94 | C |
| ATOM | 5082 | CD1 | LEU | B | 311 | 7.671 | 52.225 | 24.411 | 1.00 | 22.68 | | C |
| ANISOU | 5082 | CD1 | LEU | B | 311 | 2021 | 2702 | 3896 | −70 | 668 | −69 | C |
| ATOM | 5083 | CD2 | LEU | B | 311 | 6.649 | 50.382 | 23.076 | 1.00 | 25.52 | | C |
| ANISOU | 5083 | CD2 | LEU | B | 311 | 2678 | 3145 | 3872 | −11 | 806 | −55 | C |
| ATOM | 5084 | N | VAL | B | 312 | 7.546 | 50.371 | 27.870 | 1.00 | 26.88 | | N |
| ANISOU | 5084 | N | VAL | B | 312 | 2492 | 3378 | 4345 | −121 | 195 | −260 | N |
| ATOM | 5085 | CA | VAL | B | 312 | 6.520 | 50.008 | 28.828 | 1.00 | 20.62 | | C |
| ANISOU | 5085 | CA | VAL | B | 312 | 1792 | 2692 | 3351 | −130 | 63 | −332 | C |
| ATOM | 5086 | C | VAL | B | 312 | 5.185 | 50.107 | 28.098 | 1.00 | 33.51 | | C |
| ANISOU | 5086 | C | VAL | B | 312 | 3546 | 4406 | 4780 | −131 | 137 | −330 | C |
| ATOM | 5087 | O | VAL | B | 312 | 4.669 | 51.210 | 27.884 | 1.00 | 29.82 | | O |
| ANISOU | 5087 | O | VAL | B | 312 | 3085 | 3940 | 4305 | −136 | 139 | −340 | O |
| ATOM | 5088 | CB | VAL | B | 312 | 6.553 | 50.911 | 30.082 | 1.00 | 29.55 | | C |
| ANISOU | 5088 | CB | VAL | B | 312 | 2887 | 3805 | 4533 | −138 | −118 | −402 | C |
| ATOM | 5089 | CG1 | VAL | B | 312 | 5.463 | 50.513 | 31.074 | 1.00 | 25.57 | | C |
| ANISOU | 5089 | CG1 | VAL | B | 312 | 2501 | 3408 | 3807 | −129 | −212 | −462 | C |
| ATOM | 5090 | CG2 | VAL | B | 312 | 7.928 | 50.871 | 30.734 | 1.00 | 22.10 | | C |
| ANISOU | 5090 | CG2 | VAL | B | 312 | 1821 | 2751 | 3824 | −139 | −229 | −402 | C |
| ATOM | 5091 | N | ASP | B | 313 | 4.635 | 48.957 | 27.700 | 1.00 | 26.04 | | N |
| ANISOU | 5091 | N | ASP | B | 313 | 2692 | 3515 | 3686 | −127 | 184 | −315 | N |
| ATOM | 5092 | CA | ASP | B | 313 | 3.532 | 48.929 | 26.750 | 1.00 | 20.92 | | C |
| ANISOU | 5092 | CA | ASP | B | 313 | 2155 | 2909 | 2885 | −127 | 247 | −298 | C |
| ATOM | 5093 | C | ASP | B | 313 | 2.289 | 48.152 | 27.215 | 1.00 | 26.73 | | C |
| ANISOU | 5093 | C | ASP | B | 313 | 2966 | 3737 | 3455 | −144 | 174 | −322 | C |
| ATOM | 5094 | O | ASP | B | 313 | 2.302 | 46.916 | 27.285 | 1.00 | 24.96 | | O |
| ANISOU | 5094 | O | ASP | B | 313 | 2781 | 3527 | 3176 | −147 | 168 | −313 | O |
| ATOM | 5095 | CB | ASP | B | 313 | 4.029 | 48.352 | 25.429 | 1.00 | 26.80 | | C |
| ANISOU | 5095 | CB | ASP | B | 313 | 2965 | 3592 | 3626 | −97 | 389 | −240 | C |
| ATOM | 5096 | CG | ASP | B | 313 | 3.085 | 48.633 | 24.278 | 1.00 | 37.22 | | C |
| ANISOU | 5096 | CG | ASP | B | 313 | 4416 | 4916 | 4811 | −86 | 440 | −219 | C |
| ATOM | 5097 | OD1 | ASP | B | 313 | 1.968 | 49.140 | 24.536 | 1.00 | 37.02 | | O |
| ANISOU | 5097 | OD1 | ASP | B | 313 | 4408 | 4949 | 4710 | −110 | 356 | −248 | O |
| ATOM | 5098 | OD2 | ASP | B | 313 | 3.465 | 48.369 | 23.112 | 1.00 | 33.53 | | O |
| ANISOU | 5098 | OD2 | ASP | B | 313 | 4041 | 4383 | 4315 | −45 | 564 | −172 | O |
| ATOM | 5099 | N | SER | B | 314 | 1.207 | 48.885 | 27.505 | 1.00 | 24.82 | | N |
| ANISOU | 5099 | N | SER | B | 314 | 2734 | 3546 | 3149 | −154 | 127 | −344 | N |
| ATOM | 5100 | CA | SER | B | 314 | −0.077 | 48.270 | 27.872 | 1.00 | 21.23 | | C |
| ANISOU | 5100 | CA | SER | B | 314 | 2325 | 3167 | 2574 | −170 | 79 | −347 | C |
| ATOM | 5101 | C | SER | B | 314 | −0.775 | 47.643 | 26.653 | 1.00 | 24.18 | | C |
| ANISOU | 5101 | C | SER | B | 314 | 2787 | 3528 | 2871 | −180 | 106 | −310 | C |
| ATOM | 5102 | O | SER | B | 314 | −1.734 | 46.878 | 26.795 | 1.00 | 28.55 | | O |
| ANISOU | 5102 | O | SER | B | 314 | 3369 | 4120 | 3360 | −201 | 60 | −297 | O |
| ATOM | 5103 | CB | SER | B | 314 | −0.996 | 49.305 | 28.504 | 1.00 | 22.79 | | C |
| ANISOU | 5103 | CB | SER | B | 314 | 2497 | 3409 | 2755 | −165 | 41 | −373 | C |
| ATOM | 5104 | OG | SER | B | 314 | −1.282 | 50.315 | 27.550 | 1.00 | 24.87 | | O |
| ANISOU | 5104 | OG | SER | B | 314 | 2769 | 3640 | 3040 | −161 | 73 | −362 | O |
| ATOM | 5105 | N | GLY | B | 315 | −0.302 | 47.992 | 25.455 | 1.00 | 23.01 | | N |
| ANISOU | 5105 | N | GLY | B | 315 | 2692 | 3315 | 2737 | −161 | 175 | −288 | N |
| ATOM | 5106 | CA | GLY | B | 315 | −0.835 | 47.440 | 24.220 | 1.00 | 20.06 | | C |
| ANISOU | 5106 | CA | GLY | B | 315 | 2447 | 2903 | 2270 | −154 | 184 | −260 | C |
| ATOM | 5107 | C | GLY | B | 315 | −0.047 | 46.249 | 23.703 | 1.00 | 23.44 | | C |
| ANISOU | 5107 | C | GLY | B | 315 | 2955 | 3282 | 2671 | −131 | 237 | −244 | C |
| ATOM | 5108 | O | GLY | B | 315 | −0.194 | 45.838 | 22.552 | 1.00 | 27.37 | | O |
| ANISOU | 5108 | O | GLY | B | 315 | 3597 | 3720 | 3083 | −104 | 261 | −225 | O |
| ATOM | 5109 | N | SER | B | 316 | 0.822 | 45.712 | 24.549 | 1.00 | 19.51 | | N |
| ANISOU | 5109 | N | SER | B | 316 | 2376 | 2795 | 2242 | −132 | 250 | −253 | N |
| ATOM | 5110 | CA | SER | B | 316 | 1.513 | 44.480 | 24.222 | 1.00 | 22.97 | | C |
| ANISOU | 5110 | CA | SER | B | 316 | 2874 | 3188 | 2664 | −109 | 292 | −239 | C |
| ATOM | 5111 | C | SER | B | 316 | 1.063 | 43.406 | 25.186 | 1.00 | 18.90 | | C |
| ANISOU | 5111 | C | SER | B | 316 | 2334 | 2726 | 2119 | −145 | 195 | −253 | C |
| ATOM | 5112 | O | SER | B | 316 | 1.343 | 43.475 | 26.380 | 1.00 | 24.64 | | O |
| ANISOU | 5112 | O | SER | B | 316 | 2958 | 3497 | 2905 | −160 | 155 | −269 | O |
| ATOM | 5113 | CB | SER | B | 316 | 3.022 | 44.657 | 24.289 | 1.00 | 27.29 | | C |
| ANISOU | 5113 | CB | SER | B | 316 | 3342 | 3681 | 3347 | −73 | 397 | −223 | C |
| ATOM | 5114 | OG | SER | B | 316 | 3.679 | 43.449 | 23.957 | 1.00 | 29.70 | | O |
| ANISOU | 5114 | OG | SER | B | 316 | 3704 | 3937 | 3644 | −39 | 450 | −207 | O |
| ATOM | 5115 | N | THR | B | 317 | 0.335 | 42.438 | 24.664 | 1.00 | 18.16 | | N |
| ANISOU | 5115 | N | THR | B | 317 | 2349 | 2618 | 1934 | −155 | 147 | −245 | N |
| ATOM | 5116 | CA | THR | B | 317 | −0.228 | 41.373 | 25.481 | 1.00 | 25.15 | | C |
| ANISOU | 5116 | CA | THR | B | 317 | 3216 | 3542 | 2799 | −195 | 59 | −242 | C |
| ATOM | 5117 | C | THR | B | 317 | 0.831 | 40.741 | 26.365 | 1.00 | 23.85 | | C |
| ANISOU | 5117 | C | THR | B | 317 | 2986 | 3381 | 2693 | −183 | 78 | −246 | C |
| ATOM | 5118 | O | THR | B | 317 | 0.651 | 40.611 | 27.575 | 1.00 | 23.60 | | O |
| ANISOU | 5118 | O | THR | B | 317 | 2881 | 3406 | 2679 | −207 | 25 | −248 | O |
| ATOM | 5119 | CB | THR | B | 317 | −0.857 | 40.291 | 24.595 | 1.00 | 23.15 | | C |
| ANISOU | 5119 | CB | THR | B | 317 | 3100 | 3231 | 2466 | −201 | 2 | −231 | C |
| ATOM | 5120 | OG1 | THR | B | 317 | −1.798 | 40.907 | 23.711 | 1.00 | 23.54 | | O |
| ANISOU | 5120 | OG1 | THR | B | 317 | 3220 | 3257 | 2467 | −207 | −44 | −228 | O |
| ATOM | 5121 | CG2 | THR | B | 317 | −1.544 | 39.227 | 25.434 | 1.00 | 18.31 | | C |
| ANISOU | 5121 | CG2 | THR | B | 317 | 2451 | 2648 | 1858 | −251 | −90 | −213 | C |
| ATOM | 5122 | N | PHE | B | 318 | 1.963 | 40.403 | 25.762 | 1.00 | 20.08 | | N |
| ANISOU | 5122 | N | PHE | B | 318 | 2543 | 2835 | 2252 | −136 | 160 | −242 | N |
| ATOM | 5123 | CA | PHE | B | 318 | 3.013 | 39.733 | 26.503 | 1.00 | 18.58 | | C |
| ANISOU | 5123 | CA | PHE | B | 318 | 2288 | 2631 | 2142 | −120 | 166 | −241 | C |
| ATOM | 5124 | C | PHE | B | 318 | 4.267 | 40.605 | 26.628 | 1.00 | 23.69 | | C |
| ANISOU | 5124 | C | PHE | B | 318 | 2826 | 3243 | 2932 | −86 | 239 | −240 | C |
| ATOM | 5125 | O | PHE | B | 318 | 4.403 | 41.645 | 25.976 | 1.00 | 25.17 | | O |
| ANISOU | 5125 | O | PHE | B | 318 | 3003 | 3407 | 3152 | −70 | 312 | −232 | O |
| ATOM | 5126 | CB | PHE | B | 318 | 3.355 | 38.390 | 25.841 | 1.00 | 22.48 | | C |
| ANISOU | 5126 | CB | PHE | B | 318 | 2888 | 3057 | 2597 | −88 | 195 | −229 | C |
| ATOM | 5127 | CG | PHE | B | 318 | 2.146 | 37.495 | 25.610 | 1.00 | 26.78 | | C |
| ANISOU | 5127 | CG | PHE | B | 318 | 3542 | 3607 | 3028 | −126 | 102 | −228 | C |
| ATOM | 5128 | CD1 | PHE | B | 318 | 1.391 | 37.021 | 26.682 | 1.00 | 23.07 | | C |
| ANISOU | 5128 | CD1 | PHE | B | 318 | 3018 | 3198 | 2549 | −183 | 1 | −218 | C |
| ATOM | 5129 | CD2 | PHE | B | 318 | 1.759 | 37.150 | 24.315 | 1.00 | 31.89 | | C |
| ANISOU | 5129 | CD2 | PHE | B | 318 | 4353 | 4183 | 3582 | −99 | 113 | −230 | C |
| ATOM | 5130 | CE1 | PHE | B | 318 | 0.274 | 36.209 | 26.477 | 1.00 | 21.29 | | C |
| ANISOU | 5130 | CE1 | PHE | B | 318 | 2863 | 2961 | 2265 | −225 | −87 | −201 | C |
| ATOM | 5131 | CE2 | PHE | B | 318 | 0.644 | 36.343 | 24.089 | 1.00 | 32.15 | | C |
| ANISOU | 5131 | CE2 | PHE | B | 318 | 4477 | 4198 | 3542 | −140 | −8 | −228 | C |
| ATOM | 5132 | CZ | PHE | B | 318 | −0.100 | 35.861 | 25.183 | 1.00 | 30.16 | | C |
| ANISOU | 5132 | CZ | PHE | B | 318 | 4131 | 4005 | 3322 | −210 | −107 | −209 | C |
| ATOM | 5133 | N | THR | B | 319 | 5.167 | 40.159 | 27.492 | 1.00 | 24.63 | | N |
| ANISOU | 5133 | N | THR | B | 319 | 2859 | 3347 | 3151 | −78 | 204 | −240 | N |
| ATOM | 5134 | CA | THR | B | 319 | 6.501 | 40.718 | 27.648 | 1.00 | 19.82 | | C |
| ANISOU | 5134 | CA | THR | B | 319 | 2125 | 2675 | 2730 | −48 | 248 | −229 | C |
| ATOM | 5135 | C | THR | B | 319 | 7.474 | 40.111 | 26.619 | 1.00 | 25.95 | | C |
| ANISOU | 5135 | C | THR | B | 319 | 2920 | 3355 | 3583 | 14 | 396 | −188 | C |
| ATOM | 5136 | O | THR | B | 319 | 7.544 | 38.889 | 26.474 | 1.00 | 31.60 | | O |
| ANISOU | 5136 | O | THR | B | 319 | 3709 | 4051 | 4247 | 35 | 403 | −183 | O |
| ATOM | 5137 | CB | THR | B | 319 | 6.995 | 40.451 | 29.076 | 1.00 | 22.58 | | C |
| ANISOU | 5137 | CB | THR | B | 319 | 2387 | 3036 | 3157 | −62 | 111 | −248 | C |
| ATOM | 5138 | OG1 | THR | B | 319 | 6.139 | 41.129 | 30.010 | 1.00 | 21.97 | | O |
| ANISOU | 5138 | OG1 | THR | B | 319 | 2316 | 3035 | 2996 | −97 | 2 | −284 | O |
| ATOM | 5139 | CG2 | THR | B | 319 | 8.457 | 40.869 | 29.263 | 1.00 | 23.69 | | C |
| ANISOU | 5139 | CG2 | THR | B | 319 | 2379 | 3084 | 3537 | −33 | 119 | −232 | C |
| ATOM | 5140 | N | HIS | B | 320 | 8.202 | 40.951 | 25.892 | 1.00 | 25.98 | | N |
| ANISOU | 5140 | N | HIS | B | 320 | 2867 | 3292 | 3711 | 51 | 530 | −153 | N |
| ATOM | 5141 | CA | HIS | B | 320 | 9.082 | 40.465 | 24.832 | 1.00 | 22.41 | | C |
| ANISOU | 5141 | CA | HIS | B | 320 | 2450 | 2742 | 3325 | 129 | 718 | −102 | C |
| ATOM | 5142 | C | HIS | B | 320 | 10.537 | 40.693 | 25.159 | 1.00 | 23.80 | | C |
| ANISOU | 5142 | C | HIS | B | 320 | 2427 | 2830 | 3786 | 158 | 775 | −56 | C |
| ATOM | 5143 | O | HIS | B | 320 | 10.924 | 41.807 | 25.519 | 1.00 | 27.05 | | O |
| ANISOU | 5143 | O | HIS | B | 320 | 2695 | 3224 | 4361 | 132 | 748 | −45 | O |
| ATOM | 5144 | CB | HIS | B | 320 | 8.755 | 41.133 | 23.507 | 1.00 | 22.73 | | C |
| ANISOU | 5144 | CB | HIS | B | 320 | 2613 | 2751 | 3274 | 168 | 874 | −73 | C |
| ATOM | 5145 | CG | HIS | B | 320 | 7.359 | 40.879 | 23.030 | 1.00 | 30.46 | | C |
| ANISOU | 5145 | CG | HIS | B | 320 | 3790 | 3787 | 3995 | 146 | 803 | −112 | C |
| ATOM | 5146 | ND1 | HIS | B | 320 | 7.076 | 40.061 | 21.959 | 1.00 | 33.19 | | N |
| ANISOU | 5146 | ND1 | HIS | B | 320 | 4347 | 4083 | 4180 | 205 | 876 | −107 | N |
| ATOM | 5147 | CD2 | HIS | B | 320 | 6.166 | 41.331 | 23.483 | 1.00 | 26.54 | | C |
| ANISOU | 5147 | CD2 | HIS | B | 320 | 3310 | 3380 | 3393 | 77 | 657 | −153 | C |
| ATOM | 5148 | CE1 | HIS | B | 320 | 5.770 | 40.030 | 21.766 | 1.00 | 28.50 | | C |
| ANISOU | 5148 | CE1 | HIS | B | 320 | 3881 | 3539 | 3408 | 163 | 754 | −144 | C |
| ATOM | 5149 | NE2 | HIS | B | 320 | 5.196 | 40.797 | 22.676 | 1.00 | 26.28 | | N |
| ANISOU | 5149 | NE2 | HIS | B | 320 | 3472 | 3346 | 3168 | 85 | 633 | −166 | N |
| ATOM | 5150 | N | ILE | B | 321 | 11.347 | 39.635 | 25.028 | 1.00 | 24.71 | | N |
| ANISOU | 5150 | N | ILE | B | 321 | 2528 | 2877 | 3982 | 214 | 844 | −27 | N |
| ATOM | 5151 | CA | ILE | B | 321 | 12.757 | 39.692 | 25.422 | 1.00 | 26.46 | | C |
| ANISOU | 5151 | CA | ILE | B | 321 | 2535 | 3002 | 4517 | 242 | 877 | 23 | C |
| ATOM | 5152 | C | ILE | B | 321 | 13.649 | 39.061 | 24.371 | 1.00 | 30.68 | | C |
| ANISOU | 5152 | C | ILE | B | 321 | 3088 | 3426 | 5145 | 348 | 1126 | 96 | C |
| ATOM | 5153 | O | ILE | B | 321 | 13.173 | 38.355 | 23.501 | 1.00 | 30.48 | | O |
| ANISOU | 5153 | O | ILE | B | 321 | 3272 | 3402 | 4908 | 401 | 1235 | 89 | O |
| ATOM | 5154 | CB | ILE | B | 321 | 13.003 | 39.008 | 26.792 | 1.00 | 30.70 | | C |
| ANISOU | 5154 | CB | ILE | B | 321 | 2983 | 3559 | 5122 | 203 | 651 | −15 | C |
| ATOM | 5155 | CG1 | ILE | B | 321 | 12.471 | 37.572 | 26.791 | 1.00 | 28.36 | | C |
| ANISOU | 5155 | CG1 | ILE | B | 321 | 2850 | 3302 | 4625 | 218 | 619 | −44 | C |
| ATOM | 5156 | CG2 | ILE | B | 321 | 12.405 | 39.839 | 27.919 | 1.00 | 24.46 | | C |
| ANISOU | 5156 | CG2 | ILE | B | 321 | 2154 | 2847 | 4292 | 122 | 430 | −74 | C |
| ATOM | 5157 | CD1 | ILE | B | 321 | 12.799 | 36.810 | 28.036 | 1.00 | 24.87 | | C |
| ANISOU | 5157 | CD1 | ILE | B | 321 | 2339 | 2863 | 4249 | 195 | 427 | −66 | C |
| ATOM | 5158 | N | PRO | B | 322 | 14.948 | 39.354 | 24.421 | 1.00 | 29.54 | | N |
| ANISOU | 5158 | N | PRO | B | 322 | 2726 | 3170 | 5330 | 385 | 1221 | 170 | N |
| ATOM | 5159 | CA | PRO | B | 322 | 15.815 | 38.771 | 23.398 | 1.00 | 35.97 | | C |
| ANISOU | 5159 | CA | PRO | B | 322 | 3554 | 3868 | 6244 | 503 | 1501 | 253 | C |
| ATOM | 5160 | C | PRO | B | 322 | 15.923 | 37.254 | 23.491 | 1.00 | 35.07 | | C |
| ANISOU | 5160 | C | PRO | B | 322 | 3536 | 3743 | 6047 | 554 | 1483 | 228 | C |
| ATOM | 5161 | O | PRO | B | 322 | 15.697 | 36.670 | 24.541 | 1.00 | 31.21 | | O |
| ANISOU | 5161 | O | PRO | B | 322 | 3017 | 3309 | 5533 | 493 | 1247 | 170 | O |
| ATOM | 5162 | CB | PRO | B | 322 | 17.176 | 39.429 | 23.675 | 1.00 | 31.75 | | C |
| ANISOU | 5162 | CB | PRO | B | 322 | 2709 | 3212 | 6143 | 514 | 1565 | 345 | C |
| ATOM | 5163 | CG | PRO | B | 322 | 16.844 | 40.691 | 24.407 | 1.00 | 38.42 | | C |
| ANISOU | 5163 | CG | PRO | B | 322 | 3441 | 4104 | 7054 | 408 | 1369 | 311 | C |
| ATOM | 5164 | CD | PRO | B | 322 | 15.654 | 40.355 | 25.238 | 1.00 | 33.97 | | C |
| ANISOU | 5164 | CD | PRO | B | 322 | 3029 | 3685 | 6192 | 331 | 1105 | 192 | C |
| ATOM | 5165 | N | GLU | B | 323 | 16.319 | 36.652 | 22.381 | 1.00 | 38.04 | | N |
| ANISOU | 5165 | N | GLU | B | 323 | 4034 | 4033 | 6386 | 675 | 1747 | 280 | N |
| ATOM | 5166 | CA | GLU | B | 323 | 16.396 | 35.214 | 22.230 | 1.00 | 44.09 | | C |
| ANISOU | 5166 | CA | GLU | B | 323 | 4934 | 4770 | 7050 | 744 | 1768 | 258 | C |
| ATOM | 5167 | C | GLU | B | 323 | 17.375 | 34.611 | 23.234 | 1.00 | 48.68 | | C |
| ANISOU | 5167 | C | GLU | B | 323 | 5277 | 5299 | 7922 | 737 | 1656 | 278 | C |
| ATOM | 5168 | O | GLU | B | 323 | 17.029 | 33.654 | 23.939 | 1.00 | 45.39 | | O |
| ANISOU | 5168 | O | GLU | B | 323 | 4916 | 4928 | 7403 | 702 | 1461 | 217 | O |
| ATOM | 5169 | CB | GLU | B | 323 | 16.805 | 34.867 | 20.801 | 1.00 | 54.31 | | C |
| ANISOU | 5169 | CB | GLU | B | 323 | 6401 | 5954 | 8279 | 899 | 2107 | 320 | C |
| ATOM | 5170 | CG | GLU | B | 323 | 16.638 | 33.397 | 20.446 | 1.00 | 67.54 | | C |
| ANISOU | 5170 | CG | GLU | B | 323 | 8301 | 7596 | 9765 | 980 | 2127 | 278 | C |
| ATOM | 5171 | CD | GLU | B | 323 | 16.883 | 33.117 | 18.974 | 1.00 | 76.39 | | C |
| ANISOU | 5171 | CD | GLU | B | 323 | 9669 | 8605 | 10750 | 1149 | 2455 | 324 | C |
| ATOM | 5172 | OE1 | GLU | B | 323 | 17.867 | 33.649 | 18.415 | 1.00 | 76.67 | | O |
| ANISOU | 5172 | OE1 | GLU | B | 323 | 9592 | 8542 | 10996 | 1235 | 2728 | 434 | O |
| ATOM | 5173 | OE2 | GLU | B | 323 | 16.080 | 32.368 | 18.377 | 1.00 | 81.84 | | O |
| ANISOU | 5173 | OE2 | GLU | B | 323 | 10678 | 9299 | 11117 | 1189 | 2423 | 255 | O |
| ATOM | 5174 | N | ASP | B | 324 | 18.595 | 35.159 | 23.266 | 1.00 | 53.34 | | N |
| ANISOU | 5174 | N | ASP | B | 324 | 5601 | 5780 | 8887 | 774 | 1778 | 373 | N |
| ATOM | 5175 | CA | ASP | B | 324 | 19.606 | 34.839 | 24.285 | 1.00 | 49.60 | | C |
| ANISOU | 5175 | CA | ASP | B | 324 | 4853 | 5237 | 8755 | 758 | 1633 | 401 | C |
| ATOM | 5176 | C | ASP | B | 324 | 18.974 | 34.681 | 25.670 | 1.00 | 45.07 | | C |
| ANISOU | 5176 | C | ASP | B | 324 | 4276 | 4771 | 8079 | 635 | 1252 | 304 | C |
| ATOM | 5177 | O | ASP | B | 324 | 19.184 | 33.691 | 26.368 | 1.00 | 39.63 | | O |
| ANISOU | 5177 | O | ASP | B | 324 | 3572 | 4072 | 7414 | 637 | 1103 | 279 | O |
| ATOM | 5178 | CB | ASP | B | 324 | 20.711 | 35.928 | 24.328 | 1.00 | 62.70 | | C |
| ANISOU | 5178 | CB | ASP | B | 324 | 6195 | 6782 | 10846 | 759 | 1721 | 506 | C |
| ATOM | 5179 | CG | ASP | B | 324 | 20.164 | 37.355 | 24.613 | 1.00 | 86.95 | | C |
| ANISOU | 5179 | CG | ASP | B | 324 | 9222 | 9921 | 13894 | 651 | 1598 | 480 | C |
| ATOM | 5180 | OD1 | ASP | B | 324 | 19.039 | 37.495 | 25.119 | 1.00 | 89.66 | | O |
| ANISOU | 5180 | OD1 | ASP | B | 324 | 9724 | 10401 | 13940 | 564 | 1384 | 377 | O |
| ATOM | 5181 | OD2 | ASP | B | 324 | 20.861 | 38.356 | 24.343 | 1.00 | 85.32 | | O |
| ANISOU | 5181 | OD2 | ASP | B | 324 | 8881 | 9629 | 13908 | 625 | 1674 | 564 | O |
| ATOM | 5182 | N | LEU | B | 325 | 18.202 | 35.685 | 26.053 | 1.00 | 31.99 | | N |
| ANISOU | 5182 | N | LEU | B | 325 | 2642 | 3210 | 6304 | 539 | 1110 | 255 | N |
| ATOM | 5183 | CA | LEU | B | 325 | 17.611 | 35.746 | 27.363 | 1.00 | 32.59 | | C |
| ANISOU | 5183 | CA | LEU | B | 325 | 2720 | 3378 | 6284 | 436 | 782 | 174 | C |
| ATOM | 5184 | C | LEU | B | 325 | 16.493 | 34.734 | 27.494 | 1.00 | 36.59 | | C |
| ANISOU | 5184 | C | LEU | B | 325 | 3477 | 3992 | 6434 | 417 | 696 | 101 | C |
| ATOM | 5185 | O | LEU | B | 325 | 16.437 | 33.976 | 28.468 | 1.00 | 33.68 | | O |
| ANISOU | 5185 | O | LEU | B | 325 | 3115 | 3645 | 6036 | 389 | 495 | 67 | O |
| ATOM | 5186 | CB | LEU | B | 325 | 17.106 | 37.161 | 27.612 | 1.00 | 34.32 | | C |
| ANISOU | 5186 | CB | LEU | B | 325 | 2905 | 3655 | 6480 | 358 | 696 | 148 | C |
| ATOM | 5187 | CG | LEU | B | 325 | 16.444 | 37.573 | 28.921 | 1.00 | 41.85 | | C |
| ANISOU | 5187 | CG | LEU | B | 325 | 3877 | 4699 | 7325 | 263 | 387 | 66 | C |
| ATOM | 5188 | CD1 | LEU | B | 325 | 17.026 | 36.825 | 30.072 | 1.00 | 29.37 | | C |
| ANISOU | 5188 | CD1 | LEU | B | 325 | 2217 | 3077 | 5866 | 259 | 162 | 51 | C |
| ATOM | 5189 | CD2 | LEU | B | 325 | 16.639 | 39.082 | 29.109 | 1.00 | 34.56 | | C |
| ANISOU | 5189 | CD2 | LEU | B | 325 | 2816 | 3748 | 6567 | 217 | 334 | 73 | C |
| ATOM | 5190 | N | TYR | B | 326 | 15.619 | 34.721 | 26.492 | 1.00 | 28.56 | | N |
| ANISOU | 5190 | N | TYR | B | 326 | 2667 | 3027 | 5157 | 434 | 845 | 85 | N |
| ATOM | 5191 | CA | TYR | B | 326 | 14.453 | 33.861 | 26.514 | 1.00 | 34.04 | | C |
| ANISOU | 5191 | CA | TYR | B | 326 | 3591 | 3809 | 5532 | 406 | 758 | 22 | C |
| ATOM | 5192 | C | TYR | B | 326 | 14.849 | 32.392 | 26.678 | 1.00 | 33.73 | | C |
| ANISOU | 5192 | C | TYR | B | 326 | 3595 | 3716 | 5505 | 457 | 738 | 25 | C |
| ATOM | 5193 | O | TYR | B | 326 | 14.278 | 31.691 | 27.503 | 1.00 | 29.99 | | O |
| ANISOU | 5193 | O | TYR | B | 326 | 3185 | 3301 | 4909 | 404 | 549 | −15 | O |
| ATOM | 5194 | CB | TYR | B | 326 | 13.609 | 34.024 | 25.240 | 1.00 | 31.07 | | C |
| ANISOU | 5194 | CB | TYR | B | 326 | 3433 | 3456 | 4917 | 435 | 919 | 12 | C |
| ATOM | 5195 | CG | TYR | B | 326 | 12.387 | 33.141 | 25.302 | 1.00 | 28.40 | | C |
| ANISOU | 5195 | CG | TYR | B | 326 | 3305 | 3189 | 4295 | 394 | 795 | −47 | C |
| ATOM | 5196 | CD1 | TYR | B | 326 | 11.264 | 33.550 | 25.990 | 1.00 | 24.51 | | C |
| ANISOU | 5196 | CD1 | TYR | B | 326 | 2842 | 2811 | 3661 | 293 | 616 | −91 | C |
| ATOM | 5197 | CD2 | TYR | B | 326 | 12.389 | 31.857 | 24.727 | 1.00 | 32.53 | | C |
| ANISOU | 5197 | CD2 | TYR | B | 326 | 3990 | 3652 | 4719 | 460 | 852 | −53 | C |
| ATOM | 5198 | CE1 | TYR | B | 326 | 10.147 | 32.724 | 26.093 | 1.00 | 39.45 | | C |
| ANISOU | 5198 | CE1 | TYR | B | 326 | 4895 | 4755 | 5340 | 251 | 503 | −128 | C |
| ATOM | 5199 | CE2 | TYR | B | 326 | 11.284 | 31.025 | 24.821 | 1.00 | 25.66 | | C |
| ANISOU | 5199 | CE2 | TYR | B | 326 | 3294 | 2829 | 3627 | 414 | 716 | −100 | C |
| ATOM | 5200 | CZ | TYR | B | 326 | 10.167 | 31.463 | 25.512 | 1.00 | 36.37 | | C |
| ANISOU | 5200 | CZ | TYR | B | 326 | 4650 | 4297 | 4871 | 305 | 544 | −131 | C |
| ATOM | 5201 | OH | TYR | B | 326 | 9.061 | 30.657 | 25.627 | 1.00 | 34.88 | | O |
| ANISOU | 5201 | OH | TYR | B | 326 | 4603 | 4142 | 4506 | 253 | 415 | −160 | O |
| ATOM | 5202 | N | ASN | B | 327 | 15.825 | 31.938 | 25.894 | 1.00 | 32.05 | | N |
| ANISOU | 5202 | N | ASN | B | 327 | 3350 | 3386 | 5443 | 566 | 946 | 80 | N |
| ATOM | 5203 | CA | ASN | B | 327 | 16.228 | 30.539 | 25.941 | 1.00 | 36.97 | | C |
| ANISOU | 5203 | CA | ASN | B | 327 | 4023 | 3943 | 6080 | 629 | 948 | 83 | C |
| ATOM | 5204 | C | ASN | B | 327 | 16.780 | 30.120 | 27.303 | 1.00 | 38.92 | | C |
| ANISOU | 5204 | C | ASN | B | 327 | 4100 | 4180 | 6507 | 587 | 720 | 84 | C |
| ATOM | 5205 | O | ASN | B | 327 | 16.606 | 28.972 | 27.713 | 1.00 | 32.76 | | O |
| ANISOU | 5205 | O | ASN | B | 327 | 3406 | 3398 | 5642 | 590 | 614 | 62 | O |
| ATOM | 5206 | CB | ASN | B | 327 | 17.260 | 30.239 | 24.856 | 1.00 | 32.67 | | C |
| ANISOU | 5206 | CB | ASN | B | 327 | 3460 | 3261 | 5691 | 772 | 1244 | 152 | C |
| ATOM | 5207 | CG | ASN | B | 327 | 16.656 | 30.232 | 23.474 | 1.00 | 37.59 | | C |
| ANISOU | 5207 | CG | ASN | B | 327 | 4349 | 3874 | 6060 | 842 | 1456 | 141 | C |
| ATOM | 5208 | OD1 | ASN | B | 327 | 15.463 | 29.984 | 23.314 | 1.00 | 39.26 | | O |
| ANISOU | 5208 | OD1 | ASN | B | 327 | 4780 | 4162 | 5973 | 791 | 1348 | 73 | O |
| ATOM | 5209 | ND2 | ASN | B | 327 | 17.482 | 30.462 | 22.462 | 1.00 | 43.49 | | N |
| ANISOU | 5209 | ND2 | ASN | B | 327 | 5085 | 4510 | 6928 | 968 | 1758 | 213 | N |
| ATOM | 5210 | N | LYS | B | 328 | 17.440 | 31.050 | 27.998 | 1.00 | 30.68 | | N |
| ANISOU | 5210 | N | LYS | B | 328 | 2828 | 3117 | 5711 | 550 | 628 | 110 | N |
| ATOM | 5211 | CA | LYS | B | 328 | 17.973 | 30.746 | 29.319 | 1.00 | 32.17 | | C |
| ANISOU | 5211 | CA | LYS | B | 328 | 2878 | 3282 | 6064 | 515 | 376 | 106 | C |
| ATOM | 5212 | C | LYS | B | 328 | 16.837 | 30.550 | 30.316 | 1.00 | 32.19 | | C |
| ANISOU | 5212 | C | LYS | B | 328 | 3029 | 3410 | 5793 | 423 | 135 | 37 | C |
| ATOM | 5213 | O | LYS | B | 328 | 16.793 | 29.522 | 30.995 | 1.00 | 36.32 | | O |
| ANISOU | 5213 | O | LYS | B | 328 | 3609 | 3929 | 6263 | 422 | −3 | 26 | O |
| ATOM | 5214 | CB | LYS | B | 328 | 18.933 | 31.835 | 29.805 | 1.00 | 32.09 | | C |
| ANISOU | 5214 | CB | LYS | B | 328 | 2602 | 3198 | 6391 | 499 | 304 | 145 | C |
| ATOM | 5215 | CG | LYS | B | 328 | 20.275 | 31.885 | 29.055 | 1.00 | 45.26 | | C |
| ANISOU | 5215 | CG | LYS | B | 328 | 4058 | 4711 | 8428 | 595 | 527 | 241 | C |
| ATOM | 5216 | CD | LYS | B | 328 | 21.150 | 33.056 | 29.525 | 1.00 | 35.30 | | C |
| ANISOU | 5216 | CD | LYS | B | 328 | 2516 | 3364 | 7533 | 561 | 434 | 287 | C |
| ATOM | 5217 | CE | LYS | B | 328 | 22.582 | 32.945 | 28.999 | 1.00 | 48.94 | | C |
| ANISOU | 5217 | CE | LYS | B | 328 | 3984 | 4913 | 9699 | 655 | 623 | 401 | C |
| ATOM | 5218 | NZ | LYS | B | 328 | 22.826 | 33.770 | 27.790 | 1.00 | 52.78 | | N |
| ANISOU | 5218 | NZ | LYS | B | 328 | 4420 | 5355 | 10278 | 699 | 953 | 478 | N |
| ATOM | 5219 | N | LEU | B | 329 | 15.923 | 31.516 | 30.394 | 1.00 | 28.27 | | N |
| ANISOU | 5219 | N | LEU | B | 329 | 2596 | 3016 | 5130 | 353 | 98 | 0 | N |
| ATOM | 5220 | CA | LEU | B | 329 | 14.751 | 31.391 | 31.254 | 1.00 | 32.57 | | C |
| ANISOU | 5220 | CA | LEU | B | 329 | 3285 | 3678 | 5413 | 276 | −82 | −53 | C |
| ATOM | 5221 | C | LEU | B | 329 | 13.952 | 30.131 | 30.936 | 1.00 | 32.82 | | C |
| ANISOU | 5221 | C | LEU | B | 329 | 3509 | 3743 | 5219 | 280 | −50 | −63 | C |
| ATOM | 5222 | O | LEU | B | 329 | 13.568 | 29.368 | 31.815 | 1.00 | 26.12 | | O |
| ANISOU | 5222 | O | LEU | B | 329 | 2731 | 2924 | 4270 | 250 | −203 | −73 | O |
| ATOM | 5223 | CB | LEU | B | 329 | 13.808 | 32.586 | 31.098 | 1.00 | 32.54 | | C |
| ANISOU | 5223 | CB | LEU | B | 329 | 3329 | 3771 | 5262 | 217 | −66 | −84 | C |
| ATOM | 5224 | CG | LEU | B | 329 | 14.253 | 33.980 | 31.488 | 1.00 | 39.33 | | C |
| ANISOU | 5224 | CG | LEU | B | 329 | 4040 | 4617 | 6287 | 194 | −128 | −88 | C |
| ATOM | 5225 | CD1 | LEU | B | 329 | 13.095 | 34.918 | 31.218 | 1.00 | 42.63 | | C |
| ANISOU | 5225 | CD1 | LEU | B | 329 | 4554 | 5139 | 6504 | 143 | −93 | −122 | C |
| ATOM | 5226 | CD2 | LEU | B | 329 | 14.693 | 34.054 | 32.934 | 1.00 | 41.54 | | C |
| ANISOU | 5226 | CD2 | LEU | B | 329 | 4252 | 4872 | 6658 | 173 | −388 | −107 | C |
| ATOM | 5227 | N | ASN | B | 330 | 13.722 | 29.927 | 29.651 | 1.00 | 31.34 | | N |
| ANISOU | 5227 | N | ASN | B | 330 | 3417 | 3537 | 4956 | 321 | 147 | −58 | N |
| ATOM | 5228 | CA | ASN | B | 330 | 12.844 | 28.876 | 29.214 | 1.00 | 32.28 | | C |
| ANISOU | 5228 | CA | ASN | B | 330 | 3734 | 3674 | 4856 | 318 | 161 | −76 | C |
| ATOM | 5229 | C | ASN | B | 330 | 13.419 | 27.512 | 29.519 | 1.00 | 26.72 | | C |
| ANISOU | 5229 | C | ASN | B | 330 | 3043 | 2892 | 4216 | 364 | 115 | −60 | C |
| ATOM | 5230 | O | ASN | B | 330 | 12.676 | 26.550 | 29.678 | 1.00 | 30.48 | | O |
| ANISOU | 5230 | O | ASN | B | 330 | 3659 | 3387 | 4534 | 336 | 40 | −72 | O |
| ATOM | 5231 | CB | ASN | B | 330 | 12.561 | 28.992 | 27.723 | 1.00 | 36.67 | | C |
| ANISOU | 5231 | CB | ASN | B | 330 | 4418 | 4200 | 5314 | 369 | 363 | −81 | C |
| ATOM | 5232 | CG | ASN | B | 330 | 11.205 | 28.433 | 27.361 | 1.00 | 34.86 | | C |
| ANISOU | 5232 | CG | ASN | B | 330 | 4400 | 4019 | 4826 | 324 | 310 | −115 | C |
| ATOM | 5233 | OD1 | ASN | B | 330 | 10.232 | 28.641 | 28.076 | 1.00 | 35.95 | | O |
| ANISOU | 5233 | OD1 | ASN | B | 330 | 4552 | 4251 | 4857 | 233 | 169 | −130 | O |
| ATOM | 5234 | ND2 | ASN | B | 330 | 11.145 | 27.687 | 26.290 | 1.00 | 25.87 | | N |
| ANISOU | 5234 | ND2 | ASN | B | 330 | 3426 | 2803 | 3599 | 391 | 415 | −124 | N |
| ATOM | 5235 | N | TYR | B | 331 | 14.741 | 27.430 | 29.607 | 1.00 | 31.32 | | N |
| ANISOU | 5235 | N | TYR | B | 331 | 3468 | 3377 | 5053 | 433 | 157 | −25 | N |
| ATOM | 5236 | CA | TYR | B | 331 | 15.387 | 26.177 | 29.982 | 1.00 | 36.15 | | C |
| ANISOU | 5236 | CA | TYR | B | 331 | 4070 | 3906 | 5758 | 483 | 100 | −5 | C |
| ATOM | 5237 | C | TYR | B | 331 | 14.960 | 25.795 | 31.388 | 1.00 | 38.20 | | C |
| ANISOU | 5237 | C | TYR | B | 331 | 4347 | 4223 | 5945 | 408 | −152 | −15 | C |
| ATOM | 5238 | O | TYR | B | 331 | 14.581 | 24.649 | 31.639 | 1.00 | 37.15 | | O |
| ANISOU | 5238 | O | TYR | B | 331 | 4331 | 4081 | 5704 | 404 | −221 | −14 | O |
| ATOM | 5239 | CB | TYR | B | 331 | 16.908 | 26.284 | 29.914 | 1.00 | 40.00 | | C |
| ANISOU | 5239 | CB | TYR | B | 331 | 4346 | 4271 | 6580 | 568 | 177 | 44 | C |
| ATOM | 5240 | CG | TYR | B | 331 | 17.594 | 24.936 | 29.919 | 1.00 | 46.57 | | C |
| ANISOU | 5240 | CG | TYR | B | 331 | 5185 | 4997 | 7512 | 648 | 185 | 68 | C |
| ATOM | 5241 | CD2 | TYR | B | 331 | 18.168 | 24.434 | 31.077 | 1.00 | 47.68 | | C |
| ANISOU | 5241 | CD2 | TYR | B | 331 | 5222 | 5098 | 7797 | 638 | −25 | 85 | C |
| ATOM | 5242 | CD1 | TYR | B | 331 | 17.641 | 24.157 | 28.771 | 1.00 | 47.59 | | C |
| ANISOU | 5242 | CD1 | TYR | B | 331 | 5449 | 5057 | 7577 | 741 | 391 | 70 | C |
| ATOM | 5243 | CE2 | TYR | B | 331 | 18.782 | 23.211 | 31.095 | 1.00 | 52.11 | | C |
| ANISOU | 5243 | CE2 | TYR | B | 331 | 5786 | 5558 | 8456 | 712 | −25 | 108 | C |
| ATOM | 5244 | CE1 | TYR | B | 331 | 18.258 | 22.929 | 28.774 | 1.00 | 54.85 | | C |
| ANISOU | 5244 | CE1 | TYR | B | 331 | 6382 | 5873 | 8587 | 821 | 401 | 88 | C |
| ATOM | 5245 | CZ | TYR | B | 331 | 18.831 | 22.456 | 29.940 | 1.00 | 60.83 | | C |
| ANISOU | 5245 | CZ | TYR | B | 331 | 7009 | 6595 | 9507 | 803 | 194 | 110 | C |
| ATOM | 5246 | OH | TYR | B | 331 | 19.450 | 21.218 | 29.951 | 1.00 | 66.18 | | O |
| ANISOU | 5246 | OH | TYR | B | 331 | 7697 | 7164 | 10285 | 886 | 198 | 130 | O |
| ATOM | 5247 | N | PHE | B | 332 | 14.996 | 26.758 | 32.305 | 1.00 | 35.45 | | N |
| ANISOU | 5247 | N | PHE | B | 332 | 3900 | 3926 | 5644 | 356 | −289 | −21 | N |
| ATOM | 5248 | CA | PHE | B | 332 | 14.501 | 26.488 | 33.648 | 1.00 | 33.70 | | C |
| ANISOU | 5248 | CA | PHE | B | 332 | 3738 | 3759 | 5308 | 299 | −511 | −28 | C |
| ATOM | 5249 | C | PHE | B | 332 | 12.981 | 26.223 | 33.624 | 1.00 | 30.30 | | C |
| ANISOU | 5249 | C | PHE | B | 332 | 3492 | 3434 | 4585 | 231 | −506 | −43 | C |
| ATOM | 5250 | O | PHE | B | 332 | 12.497 | 25.330 | 34.300 | 1.00 | 29.29 | | O |
| ANISOU | 5250 | O | PHE | B | 332 | 3464 | 3320 | 4345 | 207 | −608 | −27 | O |
| ATOM | 5251 | CB | PHE | B | 332 | 14.820 | 27.642 | 34.600 | 1.00 | 35.41 | | C |
| ANISOU | 5251 | CB | PHE | B | 332 | 3848 | 3994 | 5610 | 271 | −662 | −41 | C |
| ATOM | 5252 | CG | PHE | B | 332 | 16.234 | 27.646 | 35.125 | 1.00 | 38.79 | | C |
| ANISOU | 5252 | CG | PHE | B | 332 | 4102 | 4301 | 6335 | 321 | −781 | −18 | C |
| ATOM | 5253 | CD1 | PHE | B | 332 | 17.074 | 26.565 | 34.931 | 1.00 | 39.27 | | C |
| ANISOU | 5253 | CD1 | PHE | B | 332 | 4111 | 4256 | 6555 | 386 | −761 | 18 | C |
| ATOM | 5254 | CD2 | PHE | B | 332 | 16.721 | 28.750 | 35.815 | 1.00 | 43.20 | | C |
| ANISOU | 5254 | CD2 | PHE | B | 332 | 4545 | 4837 | 7031 | 305 | −928 | −32 | C |
| ATOM | 5255 | CE1 | PHE | B | 332 | 18.368 | 26.581 | 35.422 | 1.00 | 47.43 | | C |
| ANISOU | 5255 | CE1 | PHE | B | 332 | 4961 | 5164 | 7895 | 431 | −885 | 46 | C |
| ATOM | 5256 | CE2 | PHE | B | 332 | 18.012 | 28.774 | 36.310 | 1.00 | 45.43 | | C |
| ANISOU | 5256 | CE2 | PHE | B | 332 | 4655 | 4988 | 7620 | 345 | −1073 | −8 | C |
| ATOM | 5257 | CZ | PHE | B | 332 | 18.836 | 27.691 | 36.116 | 1.00 | 49.80 | | C |
| ANISOU | 5257 | CZ | PHE | B | 332 | 5138 | 5438 | 8347 | 407 | −1052 | 35 | C |
| ATOM | 5258 | N | PHE | B | 333 | 12.225 | 26.984 | 32.841 | 1.00 | 28.16 | | N |
| ANISOU | 5258 | N | PHE | B | 333 | 3261 | 3228 | 4210 | 201 | −390 | −66 | N |
| ATOM | 5259 | CA | PHE | B | 333 | 10.779 | 26.790 | 32.842 | 1.00 | 28.16 | | C |
| ANISOU | 5259 | CA | PHE | B | 333 | 3404 | 3315 | 3978 | 134 | −402 | −71 | C |
| ATOM | 5260 | C | PHE | B | 333 | 10.381 | 25.421 | 32.261 | 1.00 | 30.48 | | C |
| ANISOU | 5260 | C | PHE | B | 333 | 3827 | 3561 | 4195 | 142 | −370 | −59 | C |
| ATOM | 5261 | O | PHE | B | 333 | 9.408 | 24.830 | 32.711 | 1.00 | 32.14 | | O |
| ANISOU | 5261 | O | PHE | B | 333 | 4131 | 3808 | 4272 | 86 | −443 | −41 | O |
| ATOM | 5262 | CB | PHE | B | 333 | 10.082 | 27.919 | 32.098 | 1.00 | 23.77 | | C |
| ANISOU | 5262 | CB | PHE | B | 333 | 2858 | 2827 | 3349 | 104 | −304 | −97 | C |
| ATOM | 5263 | CG | PHE | B | 333 | 9.876 | 29.149 | 32.938 | 1.00 | 30.91 | | C |
| ANISOU | 5263 | CG | PHE | B | 333 | 3694 | 3806 | 4245 | 66 | −378 | −111 | C |
| ATOM | 5264 | CD1 | PHE | B | 333 | 9.174 | 29.073 | 34.131 | 1.00 | 24.14 | | C |
| ANISOU | 5264 | CD1 | PHE | B | 333 | 2891 | 3013 | 3268 | 23 | −501 | −101 | C |
| ATOM | 5265 | CD2 | PHE | B | 333 | 10.356 | 30.390 | 32.526 | 1.00 | 32.66 | | C |
| ANISOU | 5265 | CD2 | PHE | B | 333 | 3813 | 4025 | 4571 | 81 | −314 | −129 | C |
| ATOM | 5266 | CE1 | PHE | B | 333 | 8.965 | 30.204 | 34.911 | 1.00 | 26.53 | | C |
| ANISOU | 5266 | CE1 | PHE | B | 333 | 3164 | 3375 | 3541 | 5 | −566 | −120 | C |
| ATOM | 5267 | CE2 | PHE | B | 333 | 10.161 | 31.524 | 33.305 | 1.00 | 25.39 | | C |
| ANISOU | 5267 | CE2 | PHE | B | 333 | 2846 | 3161 | 3641 | 50 | −397 | −150 | C |
| ATOM | 5268 | CZ | PHE | B | 333 | 9.469 | 31.436 | 34.498 | 1.00 | 25.96 | | C |
| ANISOU | 5268 | CZ | PHE | B | 333 | 2990 | 3295 | 3578 | 17 | −525 | −151 | C |
| ATOM | 5269 | N | ASP | B | 334 | 11.138 | 24.921 | 31.287 | 1.00 | 25.50 | | N |
| ANISOU | 5269 | N | ASP | B | 334 | 3202 | 2833 | 3654 | 218 | −258 | −65 | N |
| ATOM | 5270 | CA | ASP | B | 334 | 10.919 | 23.573 | 30.760 | 1.00 | 30.55 | | C |
| ANISOU | 5270 | CA | ASP | B | 334 | 3976 | 3400 | 4233 | 242 | −245 | −62 | C |
| ATOM | 5271 | C | ASP | B | 334 | 11.108 | 22.510 | 31.851 | 1.00 | 31.65 | | C |
| ANISOU | 5271 | C | ASP | B | 334 | 4117 | 3509 | 4398 | 231 | −390 | −28 | C |
| ATOM | 5272 | O | ASP | B | 334 | 10.363 | 21.549 | 31.914 | 1.00 | 34.29 | | O |
| ANISOU | 5272 | O | ASP | B | 334 | 4570 | 3830 | 4630 | 195 | −447 | −14 | O |
| ATOM | 5273 | CB | ASP | B | 334 | 11.857 | 23.257 | 29.590 | 1.00 | 26.95 | | C |
| ANISOU | 5273 | CB | ASP | B | 334 | 3536 | 2831 | 3874 | 353 | −81 | −72 | C |
| ATOM | 5274 | CG | ASP | B | 334 | 11.311 | 23.730 | 28.246 | 1.00 | 34.72 | | C |
| ANISOU | 5274 | CG | ASP | B | 334 | 4642 | 3811 | 4739 | 373 | 59 | −104 | C |
| ATOM | 5275 | OD1 | ASP | B | 334 | 10.097 | 24.039 | 28.153 | 1.00 | 25.87 | | O |
| ANISOU | 5275 | OD1 | ASP | B | 334 | 3606 | 2762 | 3461 | 294 | 0 | −120 | O |
| ATOM | 5276 | OD2 | ASP | B | 334 | 12.105 | 23.775 | 27.272 | 1.00 | 34.62 | | O |
| ANISOU | 5276 | OD2 | ASP | B | 334 | 4646 | 3713 | 4794 | 478 | 234 | −106 | O |
| ATOM | 5277 | N | ILE | B | 335 | 12.114 | 22.666 | 32.695 | 1.00 | 26.97 | | N |
| ANISOU | 5277 | N | ILE | B | 335 | 3398 | 2895 | 3957 | 263 | −460 | −10 | N |
| ATOM | 5278 | CA | ILE | B | 335 | 12.306 | 21.698 | 33.751 | 1.00 | 30.27 | | C |
| ANISOU | 5278 | CA | ILE | B | 335 | 3836 | 3279 | 4388 | 259 | −608 | 25 | C |
| ATOM | 5279 | C | ILE | B | 335 | 11.162 | 21.765 | 34.770 | 1.00 | 26.85 | | C |
| ANISOU | 5279 | C | ILE | B | 335 | 3481 | 2941 | 3779 | 171 | −722 | 50 | C |
| ATOM | 5280 | O | ILE | B | 335 | 10.669 | 20.734 | 35.205 | 1.00 | 27.07 | | O |
| ANISOU | 5280 | O | ILE | B | 335 | 3605 | 2951 | 3731 | 145 | −788 | 88 | O |
| ATOM | 5281 | CB | ILE | B | 335 | 13.670 | 21.879 | 34.421 | 1.00 | 34.85 | | C |
| ANISOU | 5281 | CB | ILE | B | 335 | 4265 | 3794 | 5183 | 318 | −688 | 38 | C |
| ATOM | 5282 | CG1 | ILE | B | 335 | 14.774 | 21.506 | 33.419 | 1.00 | 36.23 | | C |
| ANISOU | 5282 | CG1 | ILE | B | 335 | 4361 | 3851 | 5554 | 418 | −549 | 37 | C |
| ATOM | 5283 | CG2 | ILE | B | 335 | 13.767 | 21.005 | 35.663 | 1.00 | 29.13 | | C |
| ANISOU | 5283 | CG2 | ILE | B | 335 | 3585 | 3042 | 4440 | 310 | −874 | 76 | C |
| ATOM | 5284 | CD1 | ILE | B | 335 | 16.172 | 22.008 | 33.768 | 1.00 | 30.69 | | C |
| ANISOU | 5284 | CD1 | ILE | B | 335 | 3452 | 3074 | 5136 | 478 | −584 | 56 | C |
| ATOM | 5285 | N | LEU | B | 336 | 10.702 | 22.965 | 35.107 | 1.00 | 30.99 | | N |
| ANISOU | 5285 | N | LEU | B | 336 | 3971 | 3562 | 4243 | 129 | −726 | 35 | N |
| ATOM | 5286 | CA | LEU | B | 336 | 9.566 | 23.118 | 36.029 | 1.00 | 25.68 | | C |
| ANISOU | 5286 | CA | LEU | B | 336 | 3377 | 2978 | 3402 | 61 | −791 | 66 | C |
| ATOM | 5287 | C | LEU | B | 336 | 8.253 | 22.605 | 35.442 | 1.00 | 30.45 | | C |
| ANISOU | 5287 | C | LEU | B | 336 | 4078 | 3610 | 3883 | −1 | −729 | 86 | C |
| ATOM | 5288 | O | LEU | B | 336 | 7.292 | 22.391 | 36.169 | 1.00 | 25.06 | | O |
| ANISOU | 5288 | O | LEU | B | 336 | 3456 | 2974 | 3091 | −54 | −765 | 136 | O |
| ATOM | 5289 | CB | LEU | B | 336 | 9.390 | 24.580 | 36.428 | 1.00 | 25.15 | | C |
| ANISOU | 5289 | CB | LEU | B | 336 | 3255 | 2996 | 3303 | 45 | −796 | 38 | C |
| ATOM | 5290 | CG | LEU | B | 336 | 10.548 | 25.106 | 37.256 | 1.00 | 26.38 | | C |
| ANISOU | 5290 | CG | LEU | B | 336 | 3331 | 3114 | 3578 | 94 | −915 | 22 | C |
| ATOM | 5291 | CD1 | LEU | B | 336 | 10.319 | 26.581 | 37.561 | 1.00 | 25.89 | | C |
| ANISOU | 5291 | CD1 | LEU | B | 336 | 3232 | 3124 | 3483 | 78 | −925 | −14 | C |
| ATOM | 5292 | CD2 | LEU | B | 336 | 10.718 | 24.272 | 38.543 | 1.00 | 26.80 | | C |
| ANISOU | 5292 | CD2 | LEU | B | 336 | 3469 | 3133 | 3581 | 111 | −1071 | 66 | C |
| ATOM | 5293 | N | CYS | B | 337 | 8.215 | 22.447 | 34.120 | 1.00 | 24.96 | | N |
| ANISOU | 5293 | N | CYS | B | 337 | 3400 | 2872 | 3213 | 11 | −635 | 52 | N |
| ATOM | 5294 | CA | CYS | B | 337 | 7.011 | 22.028 | 33.423 | 1.00 | 24.66 | | C |
| ANISOU | 5294 | CA | CYS | B | 337 | 3454 | 2835 | 3081 | −47 | −609 | 62 | C |
| ATOM | 5295 | C | CYS | B | 337 | 7.000 | 20.512 | 33.298 | 1.00 | 35.53 | | C |
| ANISOU | 5295 | C | CYS | B | 337 | 4920 | 4109 | 4470 | −42 | −659 | 90 | C |
| ATOM | 5296 | O | CYS | B | 337 | 7.581 | 19.938 | 32.373 | 1.00 | 25.91 | | O |
| ANISOU | 5296 | O | CYS | B | 337 | 3749 | 2797 | 3299 | 17 | −619 | 54 | O |
| ATOM | 5297 | CB | CYS | B | 337 | 6.935 | 22.692 | 32.052 | 1.00 | 24.29 | | C |
| ANISOU | 5297 | CB | CYS | B | 337 | 3420 | 2780 | 3028 | −27 | −505 | 5 | C |
| ATOM | 5298 | SG | CYS | B | 337 | 5.523 | 22.227 | 30.994 | 1.00 | 33.68 | | S |
| ANISOU | 5298 | SG | CYS | B | 337 | 4741 | 3936 | 4118 | −88 | −514 | 1 | S |
| ATOM | 5299 | N | ILE | B | 338 | 6.368 | 19.868 | 34.263 | 1.00 | 30.39 | | N |
| ANISOU | 5299 | N | ILE | B | 338 | 4301 | 3470 | 3777 | −95 | −738 | 159 | N |
| ATOM | 5300 | CA | ILE | B | 338 | 6.286 | 18.422 | 34.262 | 1.00 | 28.96 | | C |
| ANISOU | 5300 | CA | ILE | B | 338 | 4202 | 3188 | 3615 | −102 | −799 | 197 | C |
| ATOM | 5301 | C | ILE | B | 338 | 4.949 | 17.962 | 33.697 | 1.00 | 26.50 | | C |
| ANISOU | 5301 | C | ILE | B | 338 | 3959 | 2849 | 3261 | −183 | −816 | 224 | C |
| ATOM | 5302 | O | ILE | B | 338 | 3.893 | 18.153 | 34.306 | 1.00 | 26.37 | | O |
| ANISOU | 5302 | O | ILE | B | 338 | 3921 | 2891 | 3206 | −259 | −828 | 290 | O |
| ATOM | 5303 | CB | ILE | B | 338 | 6.490 | 17.873 | 35.660 | 1.00 | 35.48 | | C |
| ANISOU | 5303 | CB | ILE | B | 338 | 5028 | 4016 | 4437 | −104 | −878 | 271 | C |
| ATOM | 5304 | CG1 | ILE | B | 338 | 7.847 | 18.367 | 36.181 | 1.00 | 35.94 | | C |
| ANISOU | 5304 | CG1 | ILE | B | 338 | 5015 | 4079 | 4561 | −23 | −902 | 238 | C |
| ATOM | 5305 | CG2 | ILE | B | 338 | 6.382 | 16.336 | 35.639 | 1.00 | 33.15 | | C |
| ANISOU | 5305 | CG2 | ILE | B | 338 | 4819 | 3605 | 4172 | −114 | −942 | 318 | C |
| ATOM | 5306 | CD1 | ILE | B | 338 | 7.973 | 18.356 | 37.662 | 1.00 | 35.30 | | C |
| ANISOU | 5306 | CD1 | ILE | B | 338 | 4948 | 4029 | 4436 | −20 | −992 | 297 | C |
| ATOM | 5307 | N | GLN | B | 339 | 5.014 | 17.377 | 32.509 | 1.00 | 27.22 | | N |
| ANISOU | 5307 | N | GLN | B | 339 | 4135 | 2838 | 3369 | −158 | −818 | 173 | N |
| ATOM | 5308 | CA | GLN | B | 339 | 3.835 | 17.010 | 31.739 | 1.00 | 31.11 | | C |
| ANISOU | 5308 | CA | GLN | B | 339 | 4706 | 3276 | 3840 | −226 | −868 | 178 | C |
| ATOM | 5309 | C | GLN | B | 339 | 3.428 | 15.544 | 31.966 | 1.00 | 39.83 | | C |
| ANISOU | 5309 | C | GLN | B | 339 | 5883 | 4264 | 4988 | −268 | −974 | 237 | C |
| ATOM | 5310 | O | GLN | B | 339 | 2.403 | 15.077 | 31.451 | 1.00 | 39.11 | | O |
| ANISOU | 5310 | O | GLN | B | 339 | 5848 | 4100 | 4913 | −338 | −1053 | 255 | O |
| ATOM | 5311 | CB | GLN | B | 339 | 4.119 | 17.261 | 30.254 | 1.00 | 33.96 | | C |
| ANISOU | 5311 | CB | GLN | B | 339 | 5163 | 3573 | 4168 | −163 | −826 | 80 | C |
| ATOM | 5312 | CG | GLN | B | 339 | 4.827 | 18.589 | 29.998 | 1.00 | 31.32 | | C |
| ANISOU | 5312 | CG | GLN | B | 339 | 4756 | 3329 | 3815 | −101 | −702 | 28 | C |
| ATOM | 5313 | CD | GLN | B | 339 | 5.051 | 18.885 | 28.520 | 1.00 | 32.93 | | C |
| ANISOU | 5313 | CD | GLN | B | 339 | 5076 | 3467 | 3969 | −29 | −634 | −53 | C |
| ATOM | 5314 | OE1 | GLN | B | 339 | 6.143 | 18.687 | 27.995 | 1.00 | 44.19 | | O |
| ANISOU | 5314 | OE1 | GLN | B | 339 | 6545 | 4827 | 5418 | 79 | −545 | −94 | O |
| ATOM | 5315 | NE2 | GLN | B | 339 | 4.023 | 19.386 | 27.853 | 1.00 | 32.31 | | N |
| ANISOU | 5315 | NE2 | GLN | B | 339 | 5051 | 3398 | 3826 | −81 | −667 | −70 | N |
| ATOM | 5316 | N | ASP | B | 340 | 4.228 | 14.824 | 32.748 | 1.00 | 35.66 | | N |
| ANISOU | 5316 | N | ASP | B | 340 | 5350 | 3705 | 4494 | −228 | −992 | 271 | N |
| ATOM | 5317 | CA | ASP | B | 340 | 3.989 | 13.408 | 32.947 | 1.00 | 29.64 | | C |
| ANISOU | 5317 | CA | ASP | B | 340 | 4662 | 2820 | 3781 | −257 | −1088 | 327 | C |
| ATOM | 5318 | C | ASP | B | 340 | 4.178 | 12.994 | 34.393 | 1.00 | 33.41 | | C |
| ANISOU | 5318 | C | ASP | B | 340 | 5093 | 3330 | 4274 | −271 | −1109 | 427 | C |
| ATOM | 5319 | O | ASP | B | 340 | 4.923 | 12.056 | 34.703 | 1.00 | 33.85 | | O |
| ANISOU | 5319 | O | ASP | B | 340 | 5191 | 3300 | 4368 | −222 | −1156 | 441 | O |
| ATOM | 5320 | CB | ASP | B | 340 | 4.908 | 12.577 | 32.051 | 1.00 | 34.40 | | C |
| ANISOU | 5320 | CB | ASP | B | 340 | 5377 | 3286 | 4409 | −161 | −1104 | 248 | C |
| ATOM | 5321 | CG | ASP | B | 340 | 6.374 | 12.801 | 32.341 | 1.00 | 39.07 | | C |
| ANISOU | 5321 | CG | ASP | B | 340 | 5915 | 3898 | 5029 | −48 | −1031 | 213 | C |
| ATOM | 5322 | OD1 | ASP | B | 340 | 6.719 | 13.853 | 32.923 | 1.00 | 44.47 | | O |
| ANISOU | 5322 | OD1 | ASP | B | 340 | 6487 | 4706 | 5705 | −40 | −973 | 217 | O |
| ATOM | 5323 | OD2 | ASP | B | 340 | 7.179 | 11.910 | 31.995 | 1.00 | 39.77 | | O |
| ANISOU | 5323 | OD2 | ASP | B | 340 | 6073 | 3869 | 5167 | 33 | −1042 | 184 | O |
| ATOM | 5324 | N | MET | B | 341 | 3.461 | 13.672 | 35.275 | 1.00 | 29.58 | | N |
| ANISOU | 5324 | N | MET | B | 341 | 4535 | 2955 | 3749 | −331 | −1074 | 501 | N |
| ATOM | 5325 | CA | MET | B | 341 | 3.522 | 13.361 | 36.686 | 1.00 | 33.69 | | C |
| ANISOU | 5325 | CA | MET | B | 341 | 5047 | 3505 | 4248 | −336 | −1082 | 605 | C |
| ATOM | 5326 | C | MET | B | 341 | 3.018 | 11.964 | 36.961 | 1.00 | 34.60 | | C |
| ANISOU | 5326 | C | MET | B | 341 | 5223 | 3501 | 4424 | −388 | −1153 | 703 | C |
| ATOM | 5327 | O | MET | B | 341 | 3.317 | 11.386 | 37.992 | 1.00 | 44.72 | | O |
| ANISOU | 5327 | O | MET | B | 341 | 6536 | 4764 | 5693 | −371 | −1176 | 784 | O |
| ATOM | 5328 | CB | MET | B | 341 | 2.729 | 14.382 | 37.473 | 1.00 | 35.74 | | C |
| ANISOU | 5328 | CB | MET | B | 341 | 5246 | 3895 | 4438 | −378 | −1006 | 665 | C |
| ATOM | 5329 | CG | MET | B | 341 | 3.317 | 15.770 | 37.309 | 1.00 | 42.35 | | C |
| ANISOU | 5329 | CG | MET | B | 341 | 6028 | 4842 | 5222 | −323 | −952 | 569 | C |
| ATOM | 5330 | SD | MET | B | 341 | 3.104 | 16.851 | 38.728 | 1.00 | 55.60 | | S |
| ANISOU | 5330 | SD | MET | B | 341 | 7683 | 6655 | 6786 | −308 | −893 | 624 | S |
| ATOM | 5331 | CE | MET | B | 341 | 3.835 | 15.834 | 39.997 | 1.00 | 58.17 | | C |
| ANISOU | 5331 | CE | MET | B | 341 | 8102 | 6918 | 7083 | −257 | −971 | 702 | C |
| ATOM | 5332 | N | ASN | B | 342 | 2.234 | 11.434 | 36.035 | 1.00 | 32.02 | | N |
| ANISOU | 5332 | N | ASN | B | 342 | 4920 | 3080 | 4166 | −452 | −1201 | 698 | N |
| ATOM | 5333 | CA | ASN | B | 342 | 1.695 | 10.100 | 36.153 | 1.00 | 35.02 | | C |
| ANISOU | 5333 | CA | ASN | B | 342 | 5350 | 3322 | 4635 | −512 | −1286 | 788 | C |
| ATOM | 5334 | C | ASN | B | 342 | 2.815 | 9.064 | 36.051 | 1.00 | 40.13 | | C |
| ANISOU | 5334 | C | ASN | B | 342 | 6087 | 3855 | 5304 | −432 | −1356 | 747 | C |
| ATOM | 5335 | O | ASN | B | 342 | 2.664 | 7.925 | 36.466 | 1.00 | 49.84 | | O |
| ANISOU | 5335 | O | ASN | B | 342 | 7365 | 4977 | 6596 | −461 | −1424 | 831 | O |
| ATOM | 5336 | CB | ASN | B | 342 | 0.630 | 9.880 | 35.075 | 1.00 | 42.62 | | C |
| ANISOU | 5336 | CB | ASN | B | 342 | 6320 | 4193 | 5680 | −596 | −1357 | 774 | C |
| ATOM | 5337 | CG | ASN | B | 342 | 1.196 | 9.953 | 33.660 | 1.00 | 46.52 | | C |
| ANISOU | 5337 | CG | ASN | B | 342 | 6906 | 4621 | 6148 | −529 | −1405 | 614 | C |
| ATOM | 5338 | OD1 | ASN | B | 342 | 2.137 | 10.700 | 33.391 | 1.00 | 49.64 | | O |
| ANISOU | 5338 | OD1 | ASN | B | 342 | 7303 | 5093 | 6463 | −436 | −1328 | 517 | O |
| ATOM | 5339 | ND2 | ASN | B | 342 | 0.603 | 9.191 | 32.744 | 1.00 | 43.90 | | N |
| ANISOU | 5339 | ND2 | ASN | B | 342 | 6659 | 4134 | 5888 | −573 | −1531 | 592 | N |
| ATOM | 5340 | N | ASN | B | 343 | 3.954 | 9.493 | 35.530 | 1.00 | 35.97 | | N |
| ANISOU | 5340 | N | ASN | B | 343 | 5575 | 3350 | 4741 | −328 | −1329 | 625 | N |
| ATOM | 5341 | CA | ASN | B | 343 | 5.101 | 8.625 | 35.329 | 1.00 | 33.56 | | C |
| ANISOU | 5341 | CA | ASN | B | 343 | 5339 | 2937 | 4477 | −234 | −1374 | 577 | C |
| ATOM | 5342 | C | ASN | B | 343 | 6.182 | 8.870 | 36.399 | 1.00 | 40.54 | | C |
| ANISOU | 5342 | C | ASN | B | 343 | 6174 | 3886 | 5345 | −159 | −1356 | 599 | C |
| ATOM | 5343 | O | ASN | B | 343 | 7.179 | 9.545 | 36.145 | 1.00 | 36.61 | | O |
| ANISOU | 5343 | O | ASN | B | 343 | 5628 | 3430 | 4850 | −71 | −1308 | 515 | O |
| ATOM | 5344 | CB | ASN | B | 343 | 5.657 | 8.869 | 33.919 | 1.00 | 34.06 | | C |
| ANISOU | 5344 | CB | ASN | B | 343 | 5455 | 2951 | 4537 | −154 | −1340 | 435 | C |
| ATOM | 5345 | CG | ASN | B | 343 | 6.618 | 7.802 | 33.469 | 1.00 | 34.33 | | C |
| ANISOU | 5345 | CG | ASN | B | 343 | 5583 | 2835 | 4626 | −56 | −1377 | 387 | C |
| ATOM | 5346 | OD1 | ASN | B | 343 | 7.284 | 7.163 | 34.283 | 1.00 | 36.49 | | O |
| ANISOU | 5346 | OD1 | ASN | B | 343 | 5844 | 3074 | 4948 | −19 | −1413 | 438 | O |
| ATOM | 5347 | ND2 | ASN | B | 343 | 6.709 | 7.607 | 32.162 | 1.00 | 34.69 | | N |
| ANISOU | 5347 | ND2 | ASN | B | 343 | 5740 | 2783 | 4659 | −1 | −1367 | 287 | N |
| ATOM | 5348 | N | ALA | B | 344 | 5.985 | 8.298 | 37.584 | 1.00 | 32.59 | | N |
| ANISOU | 5348 | N | ALA | B | 344 | 5115 | 4036 | 3232 | 214 | −486 | 1058 | N |
| ATOM | 5349 | CA | ALA | B | 344 | 6.849 | 8.553 | 38.739 | 1.00 | 33.82 | | C |
| ANISOU | 5349 | CA | ALA | B | 344 | 5362 | 4181 | 3308 | 283 | −609 | 1001 | C |
| ATOM | 5350 | C | ALA | B | 344 | 8.322 | 8.246 | 38.462 | 1.00 | 38.45 | | C |
| ANISOU | 5350 | C | ALA | B | 344 | 5932 | 4799 | 3879 | 367 | −775 | 959 | C |
| ATOM | 5351 | O | ALA | B | 344 | 9.219 | 8.936 | 38.954 | 1.00 | 37.81 | | O |
| ANISOU | 5351 | O | ALA | B | 344 | 5854 | 4716 | 3797 | 413 | −929 | 909 | O |
| ATOM | 5352 | CB | ALA | B | 344 | 6.361 | 7.751 | 39.947 | 1.00 | 22.79 | | C |
| ANISOU | 5352 | CB | ALA | B | 344 | 4114 | 2720 | 1826 | 309 | −588 | 966 | C |
| ATOM | 5353 | N | TYR | B | 345 | 8.562 | 7.197 | 37.688 | 1.00 | 37.82 | | N |
| ANISOU | 5353 | N | TYR | B | 345 | 5838 | 4725 | 3807 | 395 | −770 | 964 | N |
| ATOM | 5354 | CA | TYR | B | 345 | 9.907 | 6.877 | 37.237 | 1.00 | 34.40 | | C |
| ANISOU | 5354 | CA | TYR | B | 345 | 5317 | 4299 | 3454 | 466 | −891 | 868 | C |
| ATOM | 5355 | C | TYR | B | 345 | 10.568 | 8.036 | 36.461 | 1.00 | 33.20 | | C |
| ANISOU | 5355 | C | TYR | B | 345 | 4960 | 4228 | 3428 | 337 | −810 | 781 | C |
| ATOM | 5356 | O | TYR | B | 345 | 11.716 | 8.383 | 36.713 | 1.00 | 39.54 | | O |
| ANISOU | 5356 | O | TYR | B | 345 | 5608 | 5041 | 4374 | 383 | −896 | 634 | O |
| ATOM | 5357 | CB | TYR | B | 345 | 9.876 | 5.632 | 36.350 | 1.00 | 26.15 | | C |
| ANISOU | 5357 | CB | TYR | B | 345 | 4257 | 3246 | 2431 | 469 | −810 | 860 | C |
| ATOM | 5358 | CG | TYR | B | 345 | 11.184 | 5.383 | 35.640 | 1.00 | 29.89 | | C |
| ANISOU | 5358 | CG | TYR | B | 345 | 4496 | 3741 | 3120 | 462 | −787 | 665 | C |
| ATOM | 5359 | CD1 | TYR | B | 345 | 12.227 | 4.734 | 36.285 | 1.00 | 28.08 | | C |
| ANISOU | 5359 | CD1 | TYR | B | 345 | 4167 | 3431 | 3071 | 629 | −982 | 525 | C |
| ATOM | 5360 | CD2 | TYR | B | 345 | 11.386 | 5.808 | 34.324 | 1.00 | 29.83 | | C |
| ANISOU | 5360 | CD2 | TYR | B | 345 | 4374 | 3802 | 3158 | 263 | −574 | 601 | C |
| ATOM | 5361 | CE1 | TYR | B | 345 | 13.428 | 4.509 | 35.652 | 1.00 | 29.34 | | C |
| ANISOU | 5361 | CE1 | TYR | B | 345 | 4054 | 3575 | 3520 | 620 | −937 | 295 | C |
| ATOM | 5362 | CE2 | TYR | B | 345 | 12.596 | 5.583 | 33.676 | 1.00 | 29.65 | | C |
| ANISOU | 5362 | CE2 | TYR | B | 345 | 4130 | 3781 | 3355 | 216 | −481 | 369 | C |
| ATOM | 5363 | CZ | TYR | B | 345 | 13.614 | 4.931 | 34.348 | 1.00 | 35.53 | | C |
| ANISOU | 5363 | CZ | TYR | B | 345 | 4711 | 4441 | 4347 | 406 | −649 | 198 | C |
| ATOM | 5364 | OH | TYR | B | 345 | 14.832 | 4.694 | 33.726 | 1.00 | 40.90 | | O |
| ANISOU | 5364 | OH | TYR | B | 345 | 5112 | 5088 | 5341 | 362 | −538 | −85 | O |
| ATOM | 5365 | N | ASP | B | 346 | 9.850 | 8.632 | 35.518 | 1.00 | 27.96 | | N |
| ANISOU | 5365 | N | ASP | B | 346 | 4308 | 3596 | 2721 | 162 | −668 | 869 | N |
| ATOM | 5366 | CA | ASP | B | 346 | 10.462 | 9.653 | 34.692 | 1.00 | 32.32 | | C |
| ANISOU | 5366 | CA | ASP | B | 346 | 4729 | 4203 | 3350 | −4 | −590 | 797 | C |
| ATOM | 5367 | C | ASP | B | 346 | 10.637 | 10.955 | 35.450 | 1.00 | 37.70 | | C |
| ANISOU | 5367 | C | ASP | B | 346 | 5358 | 4895 | 4073 | 6 | −674 | 785 | C |
| ATOM | 5368 | O | ASP | B | 346 | 11.616 | 11.666 | 35.240 | 1.00 | 42.86 | | O |
| ANISOU | 5368 | O | ASP | B | 346 | 5865 | 5591 | 4830 | −53 | −660 | 660 | O |
| ATOM | 5369 | CB | ASP | B | 346 | 9.654 | 9.904 | 33.430 | 1.00 | 34.52 | | C |
| ANISOU | 5369 | CB | ASP | B | 346 | 5098 | 4470 | 3549 | −228 | −478 | 917 | C |
| ATOM | 5370 | CG | ASP | B | 346 | 10.434 | 10.705 | 32.398 | 1.00 | 43.09 | | C |
| ANISOU | 5370 | CG | ASP | B | 346 | 6115 | 5593 | 4663 | −459 | −373 | 825 | C |
| ATOM | 5371 | OD1 | ASP | B | 346 | 11.676 | 10.560 | 32.346 | 1.00 | 51.15 | | O |
| ANISOU | 5371 | OD1 | ASP | B | 346 | 6980 | 6657 | 5797 | −447 | −301 | 620 | O |
| ATOM | 5372 | OD2 | ASP | B | 346 | 9.811 | 11.467 | 31.632 | 1.00 | 41.99 | | O |
| ANISOU | 5372 | OD2 | ASP | B | 346 | 6084 | 5415 | 4453 | −668 | −371 | 948 | O |
| ATOM | 5373 | N | VAL | B | 347 | 9.703 | 11.244 | 36.347 | 1.00 | 32.72 | | N |
| ANISOU | 5373 | N | VAL | B | 347 | 4842 | 4214 | 3376 | 68 | −734 | 890 | N |
| ATOM | 5374 | CA | VAL | B | 347 | 9.772 | 12.453 | 37.160 | 1.00 | 38.87 | | C |
| ANISOU | 5374 | CA | VAL | B | 347 | 5586 | 4989 | 4193 | 73 | −795 | 868 | C |
| ATOM | 5375 | C | VAL | B | 347 | 11.034 | 12.409 | 38.009 | 1.00 | 40.79 | | C |
| ANISOU | 5375 | C | VAL | B | 347 | 5758 | 5255 | 4484 | 201 | −926 | 724 | C |
| ATOM | 5376 | O | VAL | B | 347 | 11.823 | 13.349 | 38.029 | 1.00 | 50.03 | | O |
| ANISOU | 5376 | O | VAL | B | 347 | 6790 | 6465 | 5754 | 166 | −955 | 632 | O |
| ATOM | 5377 | CB | VAL | B | 347 | 8.530 | 12.599 | 38.060 | 1.00 | 38.03 | | C |
| ANISOU | 5377 | CB | VAL | B | 347 | 5624 | 4798 | 4026 | 99 | −785 | 955 | C |
| ATOM | 5378 | CG1 | VAL | B | 347 | 8.747 | 13.669 | 39.088 | 1.00 | 43.88 | | C |
| ANISOU | 5378 | CG1 | VAL | B | 347 | 6351 | 5528 | 4792 | 112 | −834 | 892 | C |
| ATOM | 5379 | CG2 | VAL | B | 347 | 7.323 | 12.933 | 37.222 | 1.00 | 35.80 | | C |
| ANISOU | 5379 | CG2 | VAL | B | 347 | 5344 | 4452 | 3808 | −31 | −708 | 1074 | C |
| ATOM | 5380 | N | ASN | B | 348 | 11.233 | 11.285 | 38.676 | 1.00 | 41.25 | | N |
| ANISOU | 5380 | N | ASN | B | 348 | 5915 | 5267 | 4490 | 343 | −1033 | 705 | N |
| ATOM | 5381 | CA | ASN | B | 348 | 12.420 | 11.058 | 39.480 | 1.00 | 39.95 | | C |
| ANISOU | 5381 | CA | ASN | B | 348 | 5702 | 5069 | 4409 | 475 | −1242 | 578 | C |
| ATOM | 5382 | C | ASN | B | 348 | 13.685 | 11.132 | 38.623 | 1.00 | 38.92 | | C |
| ANISOU | 5382 | C | ASN | B | 348 | 5286 | 4980 | 4522 | 457 | −1221 | 404 | C |
| ATOM | 5383 | O | ASN | B | 348 | 14.700 | 11.688 | 39.038 | 1.00 | 42.18 | | O |
| ANISOU | 5383 | O | ASN | B | 348 | 5553 | 5382 | 5091 | 500 | −1346 | 270 | O |
| ATOM | 5384 | CB | ASN | B | 348 | 12.311 | 9.709 | 40.180 | 1.00 | 42.96 | | C |
| ANISOU | 5384 | CB | ASN | B | 348 | 6276 | 5351 | 4697 | 606 | −1396 | 615 | C |
| ATOM | 5385 | CG | ASN | B | 348 | 13.542 | 9.369 | 40.969 | 1.00 | 53.61 | | C |
| ANISOU | 5385 | CG | ASN | B | 348 | 7587 | 6609 | 6175 | 742 | −1700 | 495 | C |
| ATOM | 5386 | OD1 | ASN | B | 348 | 13.856 | 10.033 | 41.956 | 1.00 | 63.29 | | O |
| ANISOU | 5386 | OD1 | ASN | B | 348 | 8898 | 7793 | 7356 | 758 | −1869 | 476 | O |
| ATOM | 5387 | ND2 | ASN | B | 348 | 14.248 | 8.324 | 40.547 | 1.00 | 48.86 | | N |
| ANISOU | 5387 | ND2 | ASN | B | 348 | 6853 | 5949 | 5764 | 836 | −1794 | 404 | N |
| ATOM | 5388 | N | LYS | B | 349 | 13.607 | 10.620 | 37.402 | 1.00 | 34.44 | | N |
| ANISOU | 5388 | N | LYS | B | 349 | 4642 | 4448 | 3996 | 365 | −1037 | 387 | N |
| ATOM | 5389 | CA | LYS | B | 349 | 14.734 | 10.734 | 36.499 | 1.00 | 37.91 | | C |
| ANISOU | 5389 | CA | LYS | B | 349 | 4828 | 4915 | 4661 | 282 | −925 | 184 | C |
| ATOM | 5390 | C | LYS | B | 349 | 15.053 | 12.197 | 36.258 | 1.00 | 43.10 | | C |
| ANISOU | 5390 | C | LYS | B | 349 | 5389 | 5634 | 5352 | 138 | −847 | 141 | C |
| ATOM | 5391 | O | LYS | B | 349 | 16.208 | 12.580 | 36.282 | 1.00 | 48.43 | | O |
| ANISOU | 5391 | O | LYS | B | 349 | 5847 | 6305 | 6248 | 141 | −864 | −60 | O |
| ATOM | 5392 | CB | LYS | B | 349 | 14.450 | 10.025 | 35.181 | 1.00 | 42.31 | | C |
| ANISOU | 5392 | CB | LYS | B | 349 | 5394 | 5495 | 5189 | 138 | −691 | 179 | C |
| ATOM | 5393 | CG | LYS | B | 349 | 15.359 | 10.453 | 34.045 | 1.00 | 46.98 | | C |
| ANISOU | 5393 | CG | LYS | B | 349 | 5798 | 6120 | 5932 | −72 | −460 | −25 | C |
| ATOM | 5394 | CD | LYS | B | 349 | 15.861 | 9.249 | 33.268 | 1.00 | 52.86 | | C |
| ANISOU | 5394 | CD | LYS | B | 349 | 6438 | 6823 | 6823 | −104 | −305 | −198 | C |
| ATOM | 5395 | CE | LYS | B | 349 | 14.723 | 8.317 | 32.921 | 1.00 | 56.86 | | C |
| ANISOU | 5395 | CE | LYS | B | 349 | 7171 | 7327 | 7107 | −107 | −271 | −4 | C |
| ATOM | 5396 | NZ | LYS | B | 349 | 15.175 | 7.148 | 32.122 | 1.00 | 61.60 | | N |
| ANISOU | 5396 | NZ | LYS | B | 349 | 7677 | 7885 | 7845 | −156 | −98 | −179 | N |
| ATOM | 5397 | N | ARG | B | 350 | 14.023 | 13.017 | 36.057 | 1.00 | 45.28 | | N |
| ANISOU | 5397 | N | ARG | B | 350 | 5812 | 5945 | 5447 | 16 | −779 | 319 | N |
| ATOM | 5398 | CA | ARG | B | 350 | 14.220 | 14.450 | 35.856 | 1.00 | 35.20 | | C |
| ANISOU | 5398 | CA | ARG | B | 350 | 4471 | 4707 | 4197 | −126 | −734 | 304 | C |
| ATOM | 5399 | C | ARG | B | 350 | 14.945 | 15.064 | 37.054 | 1.00 | 38.44 | | C |
| ANISOU | 5399 | C | ARG | B | 350 | 4781 | 5109 | 4714 | 16 | −911 | 207 | C |
| ATOM | 5400 | O | ARG | B | 350 | 15.955 | 15.746 | 36.881 | 1.00 | 51.36 | | O |
| ANISOU | 5400 | O | ARG | B | 350 | 6233 | 6769 | 6511 | −39 | −887 | 47 | O |
| ATOM | 5401 | CB | ARG | B | 350 | 12.886 | 15.159 | 35.619 | 1.00 | 31.28 | | C |
| ANISOU | 5401 | CB | ARG | B | 350 | 4140 | 4194 | 3552 | −243 | −710 | 518 | C |
| ATOM | 5402 | CG | ARG | B | 350 | 13.046 | 16.698 | 35.478 | 1.00 | 49.21 | | C |
| ANISOU | 5402 | CG | ARG | B | 350 | 6351 | 6476 | 5869 | −384 | −706 | 516 | C |
| ATOM | 5403 | CD | ARG | B | 350 | 11.739 | 17.425 | 35.182 | 1.00 | 37.02 | | C |
| ANISOU | 5403 | CD | ARG | B | 350 | 4934 | 4862 | 4268 | −502 | −731 | 712 | C |
| ATOM | 5404 | NE | ARG | B | 350 | 11.019 | 16.786 | 34.091 | 1.00 | 43.99 | | N |
| ANISOU | 5404 | NE | ARG | B | 350 | 5954 | 5702 | 5061 | −636 | −674 | 831 | N |
| ATOM | 5405 | CZ | ARG | B | 350 | 10.206 | 17.420 | 33.257 | 1.00 | 51.73 | | C |
| ANISOU | 5405 | CZ | ARG | B | 350 | 7043 | 6592 | 6022 | −833 | −715 | 980 | C |
| ATOM | 5406 | NH1 | ARG | B | 350 | 10.011 | 18.727 | 33.390 | 1.00 | 47.79 | | N |
| ANISOU | 5406 | NH1 | ARG | B | 350 | 6509 | 6035 | 5612 | −910 | −805 | 1022 | N |
| ATOM | 5407 | NH2 | ARG | B | 350 | 9.583 | 16.745 | 32.292 | 1.00 | 53.91 | | N |
| ANISOU | 5407 | NH2 | ARG | B | 350 | 7469 | 6811 | 6204 | −959 | −698 | 1090 | N |
| ATOM | 5408 | N | LEU | B | 351 | 14.456 | 14.784 | 38.260 | 1.00 | 33.79 | | N |
| ANISOU | 5408 | N | LEU | B | 351 | 4337 | 4475 | 4029 | 175 | −1082 | 291 | N |
| ATOM | 5409 | CA | LEU | B | 351 | 15.105 | 15.231 | 39.494 | 1.00 | 35.43 | | C |
| ANISOU | 5409 | CA | LEU | B | 351 | 4525 | 4648 | 4289 | 295 | −1290 | 213 | C |
| ATOM | 5410 | C | LEU | B | 351 | 16.591 | 14.948 | 39.514 | 1.00 | 44.46 | | C |
| ANISOU | 5410 | C | LEU | B | 351 | 5436 | 5761 | 5697 | 378 | −1415 | −5 | C |
| ATOM | 5411 | O | LEU | B | 351 | 17.392 | 15.840 | 39.774 | 1.00 | 48.16 | | O |
| ANISOU | 5411 | O | LEU | B | 351 | 5753 | 6239 | 6308 | 368 | −1476 | −124 | O |
| ATOM | 5412 | CB | LEU | B | 351 | 14.465 | 14.574 | 40.712 | 1.00 | 36.92 | | C |
| ANISOU | 5412 | CB | LEU | B | 351 | 4977 | 4756 | 4294 | 416 | −1451 | 314 | C |
| ATOM | 5413 | CG | LEU | B | 351 | 13.232 | 15.285 | 41.272 | 1.00 | 45.95 | | C |
| ANISOU | 5413 | CG | LEU | B | 351 | 6313 | 5891 | 5255 | 340 | −1361 | 443 | C |
| ATOM | 5414 | CD1 | LEU | B | 351 | 12.336 | 15.815 | 40.170 | 1.00 | 41.60 | | C |
| ANISOU | 5414 | CD1 | LEU | B | 351 | 5699 | 5384 | 4724 | 195 | −1142 | 534 | C |
| ATOM | 5415 | CD2 | LEU | B | 351 | 12.464 | 14.365 | 42.228 | 1.00 | 49.06 | | C |
| ANISOU | 5415 | CD2 | LEU | B | 351 | 7009 | 6194 | 5438 | 399 | −1421 | 527 | C |
| ATOM | 5416 | N | LYS | B | 352 | 16.959 | 13.703 | 39.228 | 1.00 | 47.15 | | N |
| ANISOU | 5416 | N | LYS | B | 352 | 5723 | 6046 | 6148 | 461 | −1453 | −74 | N |
| ATOM | 5417 | CA | LYS | B | 352 | 18.364 | 13.330 | 39.202 | 1.00 | 40.49 | | C |
| ANISOU | 5417 | CA | LYS | B | 352 | 4600 | 5125 | 5660 | 548 | −1576 | −322 | C |
| ATOM | 5418 | C | LYS | B | 352 | 19.102 | 14.080 | 38.109 | 1.00 | 42.98 | | C |
| ANISOU | 5418 | C | LYS | B | 352 | 4642 | 5507 | 6179 | 371 | −1308 | −514 | C |
| ATOM | 5419 | O | LYS | B | 352 | 20.208 | 14.570 | 38.321 | 1.00 | 48.92 | | O |
| ANISOU | 5419 | O | LYS | B | 352 | 5152 | 6218 | 7218 | 396 | −1388 | −723 | O |
| ATOM | 5420 | CB | LYS | B | 352 | 18.515 | 11.825 | 39.016 | 1.00 | 43.05 | | C |
| ANISOU | 5420 | CB | LYS | B | 352 | 4901 | 5352 | 6101 | 658 | −1647 | −371 | C |
| ATOM | 5421 | CG | LYS | B | 352 | 17.982 | 11.010 | 40.181 | 1.00 | 57.12 | | C |
| ANISOU | 5421 | CG | LYS | B | 352 | 6976 | 7029 | 7698 | 821 | −1956 | −206 | C |
| ATOM | 5422 | CD | LYS | B | 352 | 19.030 | 10.998 | 41.291 | 1.00 | 67.71 | | C |
| ANISOU | 5422 | CD | LYS | B | 352 | 8258 | 8209 | 9261 | 976 | −2378 | −320 | C |
| ATOM | 5423 | CE | LYS | B | 352 | 18.443 | 10.799 | 42.676 | 1.00 | 70.79 | | C |
| ANISOU | 5423 | CE | LYS | B | 352 | 9059 | 8503 | 9334 | 1044 | −2684 | −127 | C |
| ATOM | 5424 | NZ | LYS | B | 352 | 19.506 | 10.363 | 43.635 | 1.00 | 72.70 | | N |
| ANISOU | 5424 | NZ | LYS | B | 352 | 9297 | 8525 | 9800 | 1151 | −3075 | −230 | N |
| ATOM | 5425 | N | MET | B | 353 | 18.465 | 14.228 | 36.958 | 1.00 | 41.21 | | N |
| ANISOU | 5425 | N | MET | B | 353 | 4489 | 5372 | 5797 | 165 | −999 | −441 | N |
| ATOM | 5426 | CA | MET | B | 353 | 19.079 | 14.968 | 35.872 | 1.00 | 50.21 | | C |
| ANISOU | 5426 | CA | MET | B | 353 | 5466 | 6561 | 7052 | −73 | −719 | −606 | C |
| ATOM | 5427 | C | MET | B | 353 | 19.337 | 16.392 | 36.315 | 1.00 | 54.47 | | C |
| ANISOU | 5427 | C | MET | B | 353 | 5962 | 7139 | 7595 | −118 | −775 | −608 | C |
| ATOM | 5428 | O | MET | B | 353 | 20.378 | 16.974 | 36.002 | 1.00 | 54.50 | | O |
| ANISOU | 5428 | O | MET | B | 353 | 5736 | 7137 | 7834 | −213 | −671 | −838 | O |
| ATOM | 5429 | CB | MET | B | 353 | 18.185 | 14.966 | 34.631 | 1.00 | 54.03 | | C |
| ANISOU | 5429 | CB | MET | B | 353 | 6146 | 7105 | 7279 | −324 | −446 | −467 | C |
| ATOM | 5430 | CG | MET | B | 353 | 18.019 | 13.616 | 33.959 | 1.00 | 58.17 | | C |
| ANISOU | 5430 | CG | MET | B | 353 | 6701 | 7597 | 7803 | −337 | −323 | −501 | C |
| ATOM | 5431 | SD | MET | B | 353 | 17.312 | 13.810 | 32.315 | 1.00 | 84.45 | | S |
| ANISOU | 5431 | SD | MET | B | 353 | 10260 | 10968 | 10860 | −721 | 7 | −403 | S |
| ATOM | 5432 | CE | MET | B | 353 | 18.817 | 13.842 | 31.333 | 1.00 | 39.45 | | C |
| ANISOU | 5432 | CE | MET | B | 353 | 4309 | 5240 | 5439 | −970 | 354 | −813 | C |
| ATOM | 5433 | N | THR | B | 354 | 18.390 | 16.932 | 37.073 | 1.00 | 49.97 | | N |
| ANISOU | 5433 | N | THR | B | 354 | 5602 | 6595 | 6790 | −56 | −921 | −375 | N |
| ATOM | 5434 | CA | THR | B | 354 | 18.467 | 18.315 | 37.511 | 1.00 | 48.34 | | C |
| ANISOU | 5434 | CA | THR | B | 354 | 5378 | 6421 | 6568 | −104 | −967 | −355 | C |
| ATOM | 5435 | C | THR | B | 354 | 19.486 | 18.496 | 38.627 | 1.00 | 51.77 | | C |
| ANISOU | 5435 | C | THR | B | 354 | 5653 | 6802 | 7215 | 74 | −1216 | −513 | C |
| ATOM | 5436 | O | THR | B | 354 | 20.183 | 19.510 | 38.664 | 1.00 | 52.20 | | O |
| ANISOU | 5436 | O | THR | B | 354 | 5553 | 6875 | 7406 | 9 | −1200 | −635 | O |
| ATOM | 5437 | CB | THR | B | 354 | 17.090 | 18.824 | 37.962 | 1.00 | 47.08 | | C |
| ANISOU | 5437 | CB | THR | B | 354 | 5468 | 6275 | 6147 | −110 | −1015 | −96 | C |
| ATOM | 5438 | OG1 | THR | B | 354 | 16.180 | 18.735 | 36.860 | 1.00 | 46.08 | | O |
| ANISOU | 5438 | OG1 | THR | B | 354 | 5470 | 6162 | 5877 | −286 | −839 | 47 | O |
| ATOM | 5439 | CG2 | THR | B | 354 | 17.167 | 20.276 | 38.406 | 1.00 | 52.33 | | C |
| ANISOU | 5439 | CG2 | THR | B | 354 | 6097 | 6959 | 6828 | −165 | −1054 | −93 | C |
| ATOM | 5440 | N | ASN | B | 355 | 19.591 | 17.505 | 39.513 | 1.00 | 53.51 | | N |
| ANISOU | 5440 | N | ASN | B | 355 | 5928 | 6936 | 7467 | 283 | −1471 | −510 | N |
| ATOM | 5441 | CA | ASN | B | 355 | 20.540 | 17.571 | 40.622 | 1.00 | 55.73 | | C |
| ANISOU | 5441 | CA | ASN | B | 355 | 6110 | 7119 | 7947 | 448 | −1797 | −638 | C |
| ATOM | 5442 | C | ASN | B | 355 | 21.972 | 17.630 | 40.078 | 1.00 | 64.36 | | C |
| ANISOU | 5442 | C | ASN | B | 355 | 6810 | 8161 | 9482 | 433 | −1757 | −951 | C |
| ATOM | 5443 | O | ASN | B | 355 | 22.788 | 18.433 | 40.525 | 1.00 | 65.41 | | O |
| ANISOU | 5443 | O | ASN | B | 355 | 6778 | 8264 | 9810 | 451 | −1878 | −1089 | O |
| ATOM | 5444 | CB | ASN | B | 355 | 20.362 | 16.356 | 41.550 | 1.00 | 51.92 | | C |
| ANISOU | 5444 | CB | ASN | B | 355 | 5816 | 6510 | 7400 | 638 | −2111 | −559 | C |
| ATOM | 5445 | CG | ASN | B | 355 | 21.184 | 16.453 | 42.821 | 1.00 | 56.28 | | C |
| ANISOU | 5445 | CG | ASN | B | 355 | 6377 | 6920 | 8087 | 783 | −2536 | −636 | C |
| ATOM | 5446 | OD1 | ASN | B | 355 | 21.281 | 17.523 | 43.413 | 1.00 | 57.61 | | O |
| ANISOU | 5446 | OD1 | ASN | B | 355 | 6586 | 7116 | 8188 | 745 | −2599 | −628 | O |
| ATOM | 5447 | ND2 | ASN | B | 355 | 21.764 | 15.331 | 43.260 | 1.00 | 62.65 | | N |
| ANISOU | 5447 | ND2 | ASN | B | 355 | 7164 | 7550 | 9090 | 941 | −2863 | −704 | N |
| ATOM | 5448 | N | GLU | B | 356 | 22.254 | 16.824 | 39.059 | 1.00 | 67.30 | | N |
| ANISOU | 5448 | N | GLU | B | 356 | 7026 | 8519 | 10027 | 372 | −1545 | −1087 | N |
| ATOM | 5449 | CA | GLU | B | 356 | 23.573 | 16.827 | 38.430 | 1.00 | 73.14 | | C |
| ANISOU | 5449 | CA | GLU | B | 356 | 7369 | 9190 | 11231 | 313 | −1414 | −1441 | C |
| ATOM | 5450 | C | GLU | B | 356 | 23.890 | 18.169 | 37.760 | 1.00 | 70.41 | | C |
| ANISOU | 5450 | C | GLU | B | 356 | 6921 | 8944 | 10888 | 72 | −1116 | −1539 | C |
| ATOM | 5451 | O | GLU | B | 356 | 24.913 | 18.796 | 38.052 | 1.00 | 72.26 | | O |
| ANISOU | 5451 | O | GLU | B | 356 | 6893 | 9123 | 11440 | 88 | −1186 | −1762 | O |
| ATOM | 5452 | CB | GLU | B | 356 | 23.667 | 15.684 | 37.412 | 1.00 | 77.54 | | C |
| ANISOU | 5452 | CB | GLU | B | 356 | 7820 | 9709 | 11931 | 247 | −1171 | −1575 | C |
| ATOM | 5453 | CG | GLU | B | 356 | 23.332 | 14.311 | 38.004 | 1.00 | 83.46 | | C |
| ANISOU | 5453 | CG | GLU | B | 356 | 8679 | 10349 | 12682 | 476 | −1462 | −1472 | C |
| ATOM | 5454 | CD | GLU | B | 356 | 23.154 | 13.219 | 36.952 | 1.00 | 86.46 | | C |
| ANISOU | 5454 | CD | GLU | B | 356 | 9019 | 10720 | 13113 | 390 | −1185 | −1550 | C |
| ATOM | 5455 | OE1 | GLU | B | 356 | 23.532 | 13.447 | 35.783 | 1.00 | 90.71 | | O |
| ANISOU | 5455 | OE1 | GLU | B | 356 | 9401 | 11302 | 13764 | 148 | −772 | −1755 | O |
| ATOM | 5456 | OE2 | GLU | B | 356 | 22.615 | 12.140 | 37.292 | 1.00 | 80.32 | | O |
| ANISOU | 5456 | OE2 | GLU | B | 356 | 8399 | 9884 | 12235 | 539 | −1365 | −1408 | O |
| ATOM | 5457 | N | SER | B | 357 | 22.986 | 18.618 | 36.895 | 1.00 | 64.65 | | N |
| ANISOU | 5457 | N | SER | B | 357 | 6418 | 8340 | 9808 | −155 | −823 | −1362 | N |
| ATOM | 5458 | CA | SER | B | 357 | 23.193 | 19.825 | 36.095 | 1.00 | 62.94 | | C |
| ANISOU | 5458 | CA | SER | B | 357 | 6176 | 8195 | 9544 | −437 | −535 | −1426 | C |
| ATOM | 5459 | C | SER | B | 357 | 23.286 | 21.123 | 36.892 | 1.00 | 59.00 | | C |
| ANISOU | 5459 | C | SER | B | 357 | 5676 | 7728 | 9012 | −398 | −703 | −1365 | C |
| ATOM | 5460 | O | SER | B | 357 | 24.035 | 22.020 | 36.508 | 1.00 | 61.91 | | O |
| ANISOU | 5460 | O | SER | B | 357 | 5882 | 8105 | 9536 | −562 | −542 | −1546 | O |
| ATOM | 5461 | CB | SER | B | 357 | 22.076 | 19.971 | 35.058 | 1.00 | 60.12 | | C |
| ANISOU | 5461 | CB | SER | B | 357 | 6129 | 7916 | 8796 | −687 | −292 | −1196 | C |
| ATOM | 5462 | OG | SER | B | 357 | 21.979 | 18.819 | 34.239 | 1.00 | 55.99 | | O |
| ANISOU | 5462 | OG | SER | B | 357 | 5634 | 7368 | 8273 | −761 | −106 | −1257 | O |
| ATOM | 5463 | N | PHE | B | 358 | 22.529 | 21.235 | 37.983 | 1.00 | 53.53 | | N |
| ANISOU | 5463 | N | PHE | B | 358 | 5176 | 7046 | 8117 | −211 | −994 | −1130 | N |
| ATOM | 5464 | CA | PHE | B | 358 | 22.335 | 22.540 | 38.615 | 1.00 | 55.09 | | C |
| ANISOU | 5464 | CA | PHE | B | 358 | 5437 | 7285 | 8211 | −226 | −1092 | −1035 | C |
| ATOM | 5465 | C | PHE | B | 358 | 22.650 | 22.646 | 40.115 | 1.00 | 54.33 | | C |
| ANISOU | 5465 | C | PHE | B | 358 | 5332 | 7127 | 8182 | 10 | −1462 | −1042 | C |
| ATOM | 5466 | O | PHE | B | 358 | 22.501 | 23.724 | 40.705 | 1.00 | 54.54 | | O |
| ANISOU | 5466 | O | PHE | B | 358 | 5415 | 7182 | 8124 | −6 | −1535 | −981 | O |
| ATOM | 5467 | CB | PHE | B | 358 | 20.894 | 23.000 | 38.380 | 1.00 | 56.37 | | C |
| ANISOU | 5467 | CB | PHE | B | 358 | 5898 | 7508 | 8013 | −332 | −1013 | −735 | C |
| ATOM | 5468 | CG | PHE | B | 358 | 20.558 | 23.203 | 36.935 | 1.00 | 60.29 | | C |
| ANISOU | 5468 | CG | PHE | B | 358 | 6469 | 8036 | 8403 | −614 | −719 | −692 | C |
| ATOM | 5469 | CD1 | PHE | B | 358 | 21.263 | 24.123 | 36.170 | 1.00 | 65.10 | | C |
| ANISOU | 5469 | CD1 | PHE | B | 358 | 6974 | 8658 | 9104 | −852 | −523 | −835 | C |
| ATOM | 5470 | CD2 | PHE | B | 358 | 19.546 | 22.473 | 36.334 | 1.00 | 61.64 | | C |
| ANISOU | 5470 | CD2 | PHE | B | 358 | 6847 | 8206 | 8366 | −669 | −646 | −511 | C |
| ATOM | 5471 | CE1 | PHE | B | 358 | 20.962 | 24.313 | 34.829 | 1.00 | 70.06 | | C |
| ANISOU | 5471 | CE1 | PHE | B | 358 | 7755 | 9286 | 9578 | −1168 | −271 | −786 | C |
| ATOM | 5472 | CE2 | PHE | B | 358 | 19.246 | 22.657 | 34.996 | 1.00 | 64.77 | | C |
| ANISOU | 5472 | CE2 | PHE | B | 358 | 7370 | 8603 | 8636 | −961 | −420 | −460 | C |
| ATOM | 5473 | CZ | PHE | B | 358 | 19.949 | 23.578 | 34.242 | 1.00 | 65.15 | | C |
| ANISOU | 5473 | CZ | PHE | B | 358 | 7365 | 8652 | 8736 | −1225 | −238 | −590 | C |
| ATOM | 5474 | N | ASN | B | 359 | 23.110 | 21.563 | 40.729 | 1.00 | 47.58 | | N |
| ANISOU | 5474 | N | ASN | B | 359 | 4427 | 6167 | 7485 | 209 | −1714 | −1120 | N |
| ATOM | 5475 | CA | ASN | B | 359 | 23.506 | 21.636 | 42.125 | 1.00 | 43.81 | | C |
| ANISOU | 5475 | CA | ASN | B | 359 | 3996 | 5592 | 7060 | 392 | −2116 | −1129 | C |
| ATOM | 5476 | C | ASN | B | 359 | 24.971 | 22.059 | 42.270 | 1.00 | 49.46 | | C |
| ANISOU | 5476 | C | ASN | B | 359 | 4353 | 6219 | 8222 | 432 | −2249 | −1425 | C |
| ATOM | 5477 | O | ASN | B | 359 | 25.838 | 21.240 | 42.576 | 1.00 | 52.37 | | O |
| ANISOU | 5477 | O | ASN | B | 359 | 4535 | 6428 | 8934 | 581 | −2509 | −1599 | O |
| ATOM | 5478 | CB | ASN | B | 359 | 23.254 | 20.303 | 42.819 | 1.00 | 46.01 | | C |
| ANISOU | 5478 | CB | ASN | B | 359 | 4458 | 5753 | 7271 | 570 | −2406 | −1041 | C |
| ATOM | 5479 | CG | ASN | B | 359 | 23.437 | 20.380 | 44.314 | 1.00 | 59.97 | | C |
| ANISOU | 5479 | CG | ASN | B | 359 | 6424 | 7399 | 8962 | 701 | −2844 | −989 | C |
| ATOM | 5480 | OD1 | ASN | B | 359 | 23.589 | 21.462 | 44.878 | 1.00 | 63.72 | | O |
| ANISOU | 5480 | OD1 | ASN | B | 359 | 6924 | 7900 | 9388 | 659 | −2905 | −997 | O |
| ATOM | 5481 | ND2 | ASN | B | 359 | 23.418 | 19.226 | 44.971 | 1.00 | 68.52 | | N |
| ANISOU | 5481 | ND2 | ASN | B | 359 | 7709 | 8330 | 9997 | 824 | −3108 | −920 | N |
| ATOM | 5482 | N | ASN | B | 360 | 25.223 | 23.352 | 42.059 | 1.00 | 49.98 | | N |
| ANISOU | 5482 | N | ASN | B | 360 | 4314 | 6365 | 8313 | 297 | −2089 | −1486 | N |
| ATOM | 5483 | CA | ASN | B | 360 | 26.569 | 23.943 | 42.064 | 1.00 | 45.07 | | C |
| ANISOU | 5483 | CA | ASN | B | 360 | 3329 | 5674 | 8123 | 292 | −2137 | −1785 | C |
| ATOM | 5484 | C | ASN | B | 360 | 26.443 | 25.459 | 42.340 | 1.00 | 44.12 | | C |
| ANISOU | 5484 | C | ASN | B | 360 | 3263 | 5646 | 7854 | 183 | −2075 | −1727 | C |
| ATOM | 5485 | O | ASN | B | 360 | 25.328 | 25.977 | 42.343 | 1.00 | 41.64 | | O |
| ANISOU | 5485 | O | ASN | B | 360 | 3228 | 5439 | 7156 | 98 | −1956 | −1480 | O |
| ATOM | 5486 | CB | ASN | B | 360 | 27.282 | 23.677 | 40.735 | 1.00 | 46.48 | | C |
| ANISOU | 5486 | CB | ASN | B | 360 | 3187 | 5846 | 8627 | 139 | −1769 | −2056 | C |
| ATOM | 5487 | CG | ASN | B | 360 | 26.480 | 24.151 | 39.537 | 1.00 | 52.57 | | C |
| ANISOU | 5487 | CG | ASN | B | 360 | 4124 | 6772 | 9078 | −137 | −1315 | −1928 | C |
| ATOM | 5488 | OD1 | ASN | B | 360 | 26.204 | 25.346 | 39.389 | 1.00 | 50.43 | | O |
| ANISOU | 5488 | OD1 | ASN | B | 360 | 3942 | 6591 | 8630 | −289 | −1187 | −1842 | O |
| ATOM | 5489 | ND2 | ASN | B | 360 | 26.125 | 23.220 | 38.660 | 1.00 | 44.05 | | N |
| ANISOU | 5489 | ND2 | ASN | B | 360 | 3097 | 5703 | 7938 | −216 | −1097 | −1917 | N |
| ATOM | 5490 | N | PRO | B | 361 | 27.569 | 26.172 | 42.580 | 1.00 | 46.24 | | N |
| ANISOU | 5490 | N | PRO | B | 361 | 3333 | 5839 | 8398 | 190 | −2096 | −1918 | N |
| ATOM | 5491 | CA | PRO | B | 361 | 27.479 | 27.594 | 42.979 | 1.00 | 53.56 | | C |
| ANISOU | 5491 | CA | PRO | B | 361 | 4325 | 6839 | 9188 | 109 | −2074 | −1857 | C |
| ATOM | 5492 | C | PRO | B | 361 | 26.941 | 28.577 | 41.925 | 1.00 | 43.69 | | C |
| ANISOU | 5492 | C | PRO | B | 361 | 3034 | 5747 | 7818 | −159 | −1724 | −1834 | C |
| ATOM | 5493 | O | PRO | B | 361 | 26.671 | 29.728 | 42.266 | 1.00 | 50.68 | | O |
| ANISOU | 5493 | O | PRO | B | 361 | 4004 | 6686 | 8567 | −223 | −1723 | −1748 | O |
| ATOM | 5494 | CB | PRO | B | 361 | 28.934 | 27.955 | 43.333 | 1.00 | 48.60 | | C |
| ANISOU | 5494 | CB | PRO | B | 361 | 3484 | 6062 | 8921 | 183 | −2145 | −2088 | C |
| ATOM | 5495 | CG | PRO | B | 361 | 29.763 | 26.905 | 42.733 | 1.00 | 50.94 | | C |
| ANISOU | 5495 | CG | PRO | B | 361 | 3543 | 6225 | 9587 | 233 | −2078 | −2318 | C |
| ATOM | 5496 | CD | PRO | B | 361 | 28.942 | 25.662 | 42.734 | 1.00 | 49.72 | | C |
| ANISOU | 5496 | CD | PRO | B | 361 | 3544 | 6076 | 9271 | 314 | −2193 | −2169 | C |
| ATOM | 5497 | N | LEU | B | 362 | 26.789 | 28.127 | 40.683 | 1.00 | 43.43 | | N |
| ANISOU | 5497 | N | LEU | B | 362 | 2974 | 5751 | 7775 | −321 | −1397 | −1864 | N |
| ATOM | 5498 | CA | LEU | B | 362 | 26.220 | 28.936 | 39.606 | 1.00 | 42.13 | | C |
| ANISOU | 5498 | CA | LEU | B | 362 | 2939 | 5678 | 7390 | −606 | −1049 | −1759 | C |
| ATOM | 5499 | C | LEU | B | 362 | 24.717 | 29.157 | 39.728 | 1.00 | 48.85 | | C |
| ANISOU | 5499 | C | LEU | B | 362 | 4141 | 6589 | 7831 | −620 | −1081 | −1406 | C |
| ATOM | 5500 | O | LEU | B | 362 | 24.152 | 29.964 | 39.000 | 1.00 | 55.07 | | O |
| ANISOU | 5500 | O | LEU | B | 362 | 5059 | 7412 | 8451 | −837 | −901 | −1282 | O |
| ATOM | 5501 | CB | LEU | B | 362 | 26.519 | 28.293 | 38.252 | 1.00 | 43.20 | | C |
| ANISOU | 5501 | CB | LEU | B | 362 | 3002 | 5806 | 7607 | −813 | −702 | −1905 | C |
| ATOM | 5502 | CG | LEU | B | 362 | 27.755 | 28.745 | 37.460 | 1.00 | 59.58 | | C |
| ANISOU | 5502 | CG | LEU | B | 362 | 4792 | 7840 | 10004 | −1039 | −402 | −2258 | C |
| ATOM | 5503 | CD1 | LEU | B | 362 | 29.034 | 28.770 | 38.295 | 1.00 | 48.46 | | C |
| ANISOU | 5503 | CD1 | LEU | B | 362 | 3085 | 6320 | 9008 | −813 | −586 | −2512 | C |
| ATOM | 5504 | CD2 | LEU | B | 362 | 27.929 | 27.838 | 36.253 | 1.00 | 61.45 | | C |
| ANISOU | 5504 | CD2 | LEU | B | 362 | 5010 | 8049 | 10290 | −1239 | −54 | −2410 | C |
| ATOM | 5505 | N | VAL | B | 363 | 24.069 | 28.416 | 40.622 | 1.00 | 44.55 | | N |
| ANISOU | 5505 | N | VAL | B | 363 | 3753 | 6025 | 7149 | −408 | −1316 | −1258 | N |
| ATOM | 5506 | CA | VAL | B | 363 | 22.614 | 28.456 | 40.772 | 1.00 | 36.08 | | C |
| ANISOU | 5506 | CA | VAL | B | 363 | 2978 | 4979 | 5753 | −414 | −1321 | −969 | C |
| ATOM | 5507 | C | VAL | B | 363 | 22.294 | 28.398 | 42.254 | 1.00 | 36.11 | | C |
| ANISOU | 5507 | C | VAL | B | 363 | 3114 | 4946 | 5659 | −218 | −1598 | −901 | C |
| ATOM | 5508 | O | VAL | B | 363 | 23.003 | 27.742 | 43.008 | 1.00 | 40.62 | | O |
| ANISOU | 5508 | O | VAL | B | 363 | 3631 | 5457 | 6345 | −55 | −1830 | −1012 | O |
| ATOM | 5509 | CB | VAL | B | 363 | 21.926 | 27.259 | 40.041 | 1.00 | 37.08 | | C |
| ANISOU | 5509 | CB | VAL | B | 363 | 3235 | 5107 | 5745 | −430 | −1212 | −856 | C |
| ATOM | 5510 | CG1 | VAL | B | 363 | 20.464 | 27.179 | 40.373 | 1.00 | 33.09 | | C |
| ANISOU | 5510 | CG1 | VAL | B | 363 | 2998 | 4598 | 4977 | −400 | −1252 | −596 | C |
| ATOM | 5511 | CG2 | VAL | B | 363 | 22.105 | 27.356 | 38.547 | 1.00 | 42.90 | | C |
| ANISOU | 5511 | CG2 | VAL | B | 363 | 3935 | 5866 | 6500 | −687 | −919 | −905 | C |
| ATOM | 5512 | N | GLN | B | 364 | 21.255 | 29.090 | 42.695 | 1.00 | 34.39 | | N |
| ANISOU | 5512 | N | GLN | B | 364 | 3081 | 4735 | 5251 | −255 | −1587 | −735 | N |
| ATOM | 5513 | CA | GLN | B | 364 | 20.800 | 28.893 | 44.061 | 1.00 | 38.58 | | C |
| ANISOU | 5513 | CA | GLN | B | 364 | 3813 | 5217 | 5631 | −126 | −1782 | −678 | C |
| ATOM | 5514 | C | GLN | B | 364 | 19.963 | 27.631 | 44.043 | 1.00 | 39.56 | | C |
| ANISOU | 5514 | C | GLN | B | 364 | 4134 | 5316 | 5582 | −62 | −1775 | −548 | C |
| ATOM | 5515 | O | GLN | B | 364 | 18.742 | 27.672 | 43.810 | 1.00 | 32.12 | | O |
| ANISOU | 5515 | O | GLN | B | 364 | 3334 | 4371 | 4498 | −129 | −1631 | −396 | O |
| ATOM | 5516 | CB | GLN | B | 364 | 20.013 | 30.090 | 44.593 | 1.00 | 37.54 | | C |
| ANISOU | 5516 | CB | GLN | B | 364 | 3780 | 5077 | 5409 | −206 | −1724 | −606 | C |
| ATOM | 5517 | CG | GLN | B | 364 | 19.417 | 29.859 | 45.967 | 1.00 | 51.53 | | C |
| ANISOU | 5517 | CG | GLN | B | 364 | 5815 | 6783 | 6981 | −139 | −1843 | −569 | C |
| ATOM | 5518 | CD | GLN | B | 364 | 20.429 | 29.951 | 47.080 | 1.00 | 69.25 | | C |
| ANISOU | 5518 | CD | GLN | B | 364 | 8091 | 8984 | 9236 | −58 | −2111 | −699 | C |
| ATOM | 5519 | OE1 | GLN | B | 364 | 21.462 | 30.619 | 46.949 | 1.00 | 71.04 | | O |
| ANISOU | 5519 | OE1 | GLN | B | 364 | 8095 | 9232 | 9665 | −57 | −2184 | −828 | O |
| ATOM | 5520 | NE2 | GLN | B | 364 | 20.147 | 29.267 | 48.191 | 1.00 | 76.43 | | N |
| ANISOU | 5520 | NE2 | GLN | B | 364 | 9305 | 9811 | 9924 | −10 | −2275 | −667 | N |
| ATOM | 5521 | N | PHE | B | 365 | 20.634 | 26.504 | 44.243 | 1.00 | 35.99 | | N |
| ANISOU | 5521 | N | PHE | B | 365 | 3665 | 4824 | 5186 | 66 | −1941 | −620 | N |
| ATOM | 5522 | CA | PHE | B | 365 | 19.990 | 25.230 | 44.021 | 1.00 | 41.78 | | C |
| ANISOU | 5522 | CA | PHE | B | 365 | 4549 | 5536 | 5790 | 119 | −1921 | −513 | C |
| ATOM | 5523 | C | PHE | B | 365 | 18.870 | 24.928 | 45.004 | 1.00 | 39.31 | | C |
| ANISOU | 5523 | C | PHE | B | 365 | 4571 | 5172 | 5194 | 143 | −1966 | −369 | C |
| ATOM | 5524 | O | PHE | B | 365 | 17.873 | 24.306 | 44.645 | 1.00 | 44.92 | | O |
| ANISOU | 5524 | O | PHE | B | 365 | 5412 | 5884 | 5772 | 121 | −1830 | −243 | O |
| ATOM | 5525 | CB | PHE | B | 365 | 21.001 | 24.101 | 44.077 | 1.00 | 51.15 | | C |
| ANISOU | 5525 | CB | PHE | B | 365 | 5628 | 6656 | 7151 | 257 | −2124 | −638 | C |
| ATOM | 5526 | CG | PHE | B | 365 | 20.398 | 22.773 | 43.773 | 1.00 | 56.17 | | C |
| ANISOU | 5526 | CG | PHE | B | 365 | 6400 | 7269 | 7673 | 310 | −2097 | −536 | C |
| ATOM | 5527 | CD1 | PHE | B | 365 | 19.716 | 22.577 | 42.587 | 1.00 | 50.68 | | C |
| ANISOU | 5527 | CD1 | PHE | B | 365 | 5682 | 6647 | 6927 | 202 | −1810 | −453 | C |
| ATOM | 5528 | CD2 | PHE | B | 365 | 20.483 | 21.729 | 44.677 | 1.00 | 64.68 | | C |
| ANISOU | 5528 | CD2 | PHE | B | 365 | 7665 | 8234 | 8678 | 449 | −2381 | −512 | C |
| ATOM | 5529 | CE1 | PHE | B | 365 | 19.146 | 21.361 | 42.298 | 1.00 | 52.98 | | C |
| ANISOU | 5529 | CE1 | PHE | B | 365 | 6097 | 6917 | 7115 | 248 | −1781 | −362 | C |
| ATOM | 5530 | CE2 | PHE | B | 365 | 19.916 | 20.510 | 44.393 | 1.00 | 62.76 | | C |
| ANISOU | 5530 | CE2 | PHE | B | 365 | 7551 | 7966 | 8331 | 494 | −2351 | −417 | C |
| ATOM | 5531 | CZ | PHE | B | 365 | 19.246 | 20.326 | 43.202 | 1.00 | 56.00 | | C |
| ANISOU | 5531 | CZ | PHE | B | 365 | 6634 | 7201 | 7441 | 401 | −2037 | −348 | C |
| ATOM | 5532 | N | ASP | B | 366 | 19.073 | 25.335 | 46.246 | 1.00 | 37.14 | | N |
| ANISOU | 5532 | N | ASP | B | 366 | 4445 | 4836 | 4829 | 167 | −2150 | −409 | N |
| ATOM | 5533 | CA | ASP | B | 366 | 18.078 | 25.241 | 47.302 | 1.00 | 39.35 | | C |
| ANISOU | 5533 | CA | ASP | B | 366 | 5078 | 5050 | 4825 | 125 | −2142 | −324 | C |
| ATOM | 5534 | C | ASP | B | 366 | 16.700 | 25.683 | 46.811 | 1.00 | 38.45 | | C |
| ANISOU | 5534 | C | ASP | B | 366 | 4984 | 4965 | 4659 | 11 | −1820 | −225 | C |
| ATOM | 5535 | O | ASP | B | 366 | 15.719 | 24.955 | 46.948 | 1.00 | 39.96 | | O |
| ANISOU | 5535 | O | ASP | B | 366 | 5376 | 5112 | 4695 | −5 | −1720 | −137 | O |
| ATOM | 5536 | CB | ASP | B | 366 | 18.514 | 26.087 | 48.491 | 1.00 | 53.13 | | C |
| ANISOU | 5536 | CB | ASP | B | 366 | 6944 | 6740 | 6503 | 89 | −2303 | −409 | C |
| ATOM | 5537 | CG | ASP | B | 366 | 19.446 | 25.344 | 49.400 | 1.00 | 68.88 | | C |
| ANISOU | 5537 | CG | ASP | B | 366 | 9110 | 8619 | 8441 | 182 | −2702 | −457 | C |
| ATOM | 5538 | OD1 | ASP | B | 366 | 19.560 | 24.111 | 49.229 | 1.00 | 70.17 | | O |
| ANISOU | 5538 | OD1 | ASP | B | 366 | 9337 | 8729 | 8593 | 274 | −2838 | −411 | O |
| ATOM | 5539 | OD2 | ASP | B | 366 | 20.065 | 25.987 | 50.278 | 1.00 | 80.62 | | O |
| ANISOU | 5539 | OD2 | ASP | B | 366 | 10675 | 10047 | 9911 | 160 | −2909 | −537 | O |
| ATOM | 5540 | N | ASP | B | 367 | 16.641 | 26.887 | 46.248 | 1.00 | 32.11 | | N |
| ANISOU | 5540 | N | ASP | B | 367 | 3969 | 4211 | 4019 | −72 | −1683 | −246 | N |
| ATOM | 5541 | CA | ASP | B | 367 | 15.393 | 27.452 | 45.748 | 1.00 | 30.76 | | C |
| ANISOU | 5541 | CA | ASP | B | 367 | 3774 | 4020 | 3893 | −179 | −1449 | −163 | C |
| ATOM | 5542 | C | ASP | B | 367 | 14.841 | 26.688 | 44.560 | 1.00 | 29.47 | | C |
| ANISOU | 5542 | C | ASP | B | 367 | 3563 | 3873 | 3760 | −185 | −1352 | −45 | C |
| ATOM | 5543 | O | ASP | B | 367 | 13.629 | 26.619 | 44.359 | 1.00 | 35.63 | | O |
| ANISOU | 5543 | O | ASP | B | 367 | 4406 | 4590 | 4543 | −240 | −1216 | 40 | O |
| ATOM | 5544 | CB | ASP | B | 367 | 15.592 | 28.905 | 45.335 | 1.00 | 39.67 | | C |
| ANISOU | 5544 | CB | ASP | B | 367 | 4690 | 5169 | 5216 | −270 | −1394 | −203 | C |
| ATOM | 5545 | CG | ASP | B | 367 | 16.031 | 29.768 | 46.476 | 1.00 | 47.68 | | C |
| ANISOU | 5545 | CG | ASP | B | 367 | 5744 | 6162 | 6210 | −281 | −1465 | −322 | C |
| ATOM | 5546 | OD1 | ASP | B | 367 | 15.805 | 29.361 | 47.638 | 1.00 | 49.20 | | O |
| ANISOU | 5546 | OD1 | ASP | B | 367 | 6189 | 6295 | 6210 | −269 | −1507 | −359 | O |
| ATOM | 5547 | OD2 | ASP | B | 367 | 16.592 | 30.852 | 46.202 | 1.00 | 45.92 | | O |
| ANISOU | 5547 | OD2 | ASP | B | 367 | 5332 | 5971 | 6144 | −327 | −1476 | −379 | O |
| ATOM | 5548 | N | PHE | B | 368 | 15.739 | 26.156 | 43.743 | 1.00 | 35.65 | | N |
| ANISOU | 5548 | N | PHE | B | 368 | 4221 | 4725 | 4601 | −145 | −1412 | −61 | N |
| ATOM | 5549 | CA | PHE | B | 368 | 15.335 | 25.446 | 42.547 | 1.00 | 33.27 | | C |
| ANISOU | 5549 | CA | PHE | B | 368 | 3893 | 4441 | 4309 | −182 | −1313 | 36 | C |
| ATOM | 5550 | C | PHE | B | 368 | 14.696 | 24.115 | 42.975 | 1.00 | 34.79 | | C |
| ANISOU | 5550 | C | PHE | B | 368 | 4287 | 4592 | 4338 | −91 | −1327 | 102 | C |
| ATOM | 5551 | O | PHE | B | 368 | 13.578 | 23.782 | 42.575 | 1.00 | 37.21 | | O |
| ANISOU | 5551 | O | PHE | B | 368 | 4672 | 4856 | 4608 | −135 | −1214 | 214 | O |
| ATOM | 5552 | CB | PHE | B | 368 | 16.545 | 25.247 | 41.632 | 1.00 | 32.43 | | C |
| ANISOU | 5552 | CB | PHE | B | 368 | 3603 | 4402 | 4315 | −199 | −1320 | −55 | C |
| ATOM | 5553 | CG | PHE | B | 368 | 16.200 | 24.810 | 40.231 | 1.00 | 32.57 | | C |
| ANISOU | 5553 | CG | PHE | B | 368 | 3611 | 4434 | 4330 | −317 | −1179 | 28 | C |
| ATOM | 5554 | CD1 | PHE | B | 368 | 14.897 | 24.552 | 39.858 | 1.00 | 27.30 | | C |
| ANISOU | 5554 | CD1 | PHE | B | 368 | 3081 | 3714 | 3579 | −367 | −1116 | 195 | C |
| ATOM | 5555 | CD2 | PHE | B | 368 | 17.187 | 24.699 | 39.275 | 1.00 | 45.14 | | C |
| ANISOU | 5555 | CD2 | PHE | B | 368 | 5063 | 6072 | 6018 | −405 | −1100 | −81 | C |
| ATOM | 5556 | CE1 | PHE | B | 368 | 14.591 | 24.159 | 38.578 | 1.00 | 26.94 | | C |
| ANISOU | 5556 | CE1 | PHE | B | 368 | 3067 | 3662 | 3507 | −496 | −1025 | 281 | C |
| ATOM | 5557 | CE2 | PHE | B | 368 | 16.886 | 24.304 | 37.980 | 1.00 | 48.09 | | C |
| ANISOU | 5557 | CE2 | PHE | B | 368 | 5487 | 6445 | 6341 | −563 | −954 | −14 | C |
| ATOM | 5558 | CZ | PHE | B | 368 | 15.582 | 24.035 | 37.632 | 1.00 | 36.63 | | C |
| ANISOU | 5558 | CZ | PHE | B | 368 | 4208 | 4942 | 4769 | −607 | −940 | 184 | C |
| ATOM | 5559 | N | ARG | B | 369 | 15.386 | 23.384 | 43.837 | 1.00 | 35.59 | | N |
| ANISOU | 5559 | N | ARG | B | 369 | 4485 | 4681 | 4356 | 28 | −1494 | 33 | N |
| ATOM | 5560 | CA | ARG | B | 369 | 14.849 | 22.136 | 44.364 | 1.00 | 36.61 | | C |
| ANISOU | 5560 | CA | ARG | B | 369 | 4853 | 4752 | 4305 | 99 | −1536 | 96 | C |
| ATOM | 5561 | C | ARG | B | 369 | 13.582 | 22.395 | 45.199 | 1.00 | 41.64 | | C |
| ANISOU | 5561 | C | ARG | B | 369 | 5718 | 5311 | 4792 | 24 | −1408 | 144 | C |
| ATOM | 5562 | O | ARG | B | 369 | 12.647 | 21.588 | 45.191 | 1.00 | 34.73 | | O |
| ANISOU | 5562 | O | ARG | B | 369 | 4996 | 4388 | 3811 | 16 | −1307 | 221 | O |
| ATOM | 5563 | CB | ARG | B | 369 | 15.912 | 21.416 | 45.192 | 1.00 | 42.66 | | C |
| ANISOU | 5563 | CB | ARG | B | 369 | 5705 | 5472 | 5031 | 222 | −1818 | 16 | C |
| ATOM | 5564 | CG | ARG | B | 369 | 15.383 | 20.267 | 46.022 | 1.00 | 58.93 | | C |
| ANISOU | 5564 | CG | ARG | B | 369 | 8101 | 7436 | 6853 | 264 | −1912 | 86 | C |
| ATOM | 5565 | CD | ARG | B | 369 | 16.474 | 19.626 | 46.861 | 1.00 | 67.12 | | C |
| ANISOU | 5565 | CD | ARG | B | 369 | 9251 | 8376 | 7875 | 372 | −2284 | 23 | C |
| ATOM | 5566 | NE | ARG | B | 369 | 15.988 | 18.433 | 47.549 | 1.00 | 80.23 | | N |
| ANISOU | 5566 | NE | ARG | B | 369 | 11274 | 9922 | 9289 | 390 | −2400 | 110 | N |
| ATOM | 5567 | CZ | ARG | B | 369 | 15.364 | 18.451 | 48.726 | 1.00 | 88.77 | | C |
| ANISOU | 5567 | CZ | ARG | B | 369 | 12764 | 10906 | 10060 | 284 | −2416 | 148 | C |
| ATOM | 5568 | NH1 | ARG | B | 369 | 15.148 | 19.606 | 49.344 | 1.00 | 91.57 | | N |
| ANISOU | 5568 | NH1 | ARG | B | 369 | 13186 | 11267 | 10339 | 164 | −2314 | 94 | N |
| ATOM | 5569 | NH2 | ARG | B | 369 | 14.956 | 17.317 | 49.286 | 1.00 | 88.24 | | N |
| ANISOU | 5569 | NH2 | ARG | B | 369 | 13018 | 10723 | 9785 | 266 | −2460 | 220 | N |
| ATOM | 5570 | N | LYS | B | 370 | 13.552 | 23.522 | 45.913 | 1.00 | 43.29 | | N |
| ANISOU | 5570 | N | LYS | B | 370 | 5937 | 5496 | 5017 | −45 | −1384 | 73 | N |
| ATOM | 5571 | CA | LYS | B | 370 | 12.377 | 23.894 | 46.695 | 1.00 | 43.55 | | C |
| ANISOU | 5571 | CA | LYS | B | 370 | 6145 | 5433 | 4968 | −152 | −1202 | 57 | C |
| ATOM | 5572 | C | LYS | B | 370 | 11.172 | 23.994 | 45.761 | 1.00 | 42.58 | | C |
| ANISOU | 5572 | C | LYS | B | 370 | 5889 | 5276 | 5015 | −209 | −996 | 135 | C |
| ATOM | 5573 | O | LYS | B | 370 | 10.107 | 23.422 | 46.014 | 1.00 | 41.77 | | O |
| ANISOU | 5573 | O | LYS | B | 370 | 5930 | 5086 | 4855 | −249 | −848 | 155 | O |
| ATOM | 5574 | CB | LYS | B | 370 | 12.611 | 25.218 | 47.418 | 1.00 | 46.44 | | C |
| ANISOU | 5574 | CB | LYS | B | 370 | 6478 | 5779 | 5386 | −229 | −1188 | −54 | C |
| ATOM | 5575 | CG | LYS | B | 370 | 11.527 | 25.629 | 48.392 | 1.00 | 52.35 | | C |
| ANISOU | 5575 | CG | LYS | B | 370 | 7417 | 6406 | 6067 | −368 | −966 | −136 | C |
| ATOM | 5576 | CD | LYS | B | 370 | 11.847 | 26.987 | 49.030 | 1.00 | 59.87 | | C |
| ANISOU | 5576 | CD | LYS | B | 370 | 8310 | 7342 | 7096 | −449 | −948 | −262 | C |
| ATOM | 5577 | CE | LYS | B | 370 | 10.715 | 27.475 | 49.940 | 1.00 | 64.78 | | C |
| ANISOU | 5577 | CE | LYS | B | 370 | 9083 | 7820 | 7709 | −622 | −659 | −393 | C |
| ATOM | 5578 | NZ | LYS | B | 370 | 11.014 | 28.797 | 50.562 | 1.00 | 64.03 | | N |
| ANISOU | 5578 | NZ | LYS | B | 370 | 8929 | 7703 | 7697 | −711 | −623 | −531 | N |
| ATOM | 5579 | N | SER | B | 371 | 11.376 | 24.695 | 44.654 | 1.00 | 36.16 | | N |
| ANISOU | 5579 | N | SER | B | 371 | 4816 | 4511 | 4413 | −229 | −1009 | 178 | N |
| ATOM | 5580 | CA | SER | B | 371 | 10.330 | 24.908 | 43.663 | 1.00 | 32.68 | | C |
| ANISOU | 5580 | CA | SER | B | 371 | 4254 | 4002 | 4162 | −299 | −906 | 272 | C |
| ATOM | 5581 | C | SER | B | 371 | 9.836 | 23.586 | 43.072 | 1.00 | 28.98 | | C |
| ANISOU | 5581 | C | SER | B | 371 | 3874 | 3530 | 3605 | −258 | −882 | 376 | C |
| ATOM | 5582 | O | SER | B | 371 | 8.628 | 23.294 | 43.066 | 1.00 | 26.16 | | O |
| ANISOU | 5582 | O | SER | B | 371 | 3562 | 3062 | 3316 | −294 | −766 | 409 | O |
| ATOM | 5583 | CB | SER | B | 371 | 10.847 | 25.836 | 42.556 | 1.00 | 27.84 | | C |
| ANISOU | 5583 | CB | SER | B | 371 | 3428 | 3429 | 3720 | −364 | −980 | 315 | C |
| ATOM | 5584 | OG | SER | B | 371 | 9.837 | 26.119 | 41.611 | 1.00 | 33.69 | | O |
| ANISOU | 5584 | OG | SER | B | 371 | 4094 | 4059 | 4647 | −456 | −958 | 424 | O |
| ATOM | 5585 | N | LEU | B | 372 | 10.772 | 22.776 | 42.596 | 1.00 | 28.43 | | N |
| ANISOU | 5585 | N | LEU | B | 372 | 3813 | 3567 | 3421 | −185 | −983 | 403 | N |
| ATOM | 5586 | CA | LEU | B | 372 | 10.407 | 21.461 | 42.065 | 1.00 | 36.21 | | C |
| ANISOU | 5586 | CA | LEU | B | 372 | 4888 | 4556 | 4315 | −142 | −963 | 489 | C |
| ATOM | 5587 | C | LEU | B | 372 | 9.592 | 20.622 | 43.046 | 1.00 | 31.00 | | C |
| ANISOU | 5587 | C | LEU | B | 372 | 4455 | 3815 | 3507 | −106 | −889 | 483 | C |
| ATOM | 5588 | O | LEU | B | 372 | 8.597 | 20.030 | 42.652 | 1.00 | 32.36 | | O |
| ANISOU | 5588 | O | LEU | B | 372 | 4669 | 3925 | 3702 | −127 | −792 | 556 | O |
| ATOM | 5589 | CB | LEU | B | 372 | 11.648 | 20.689 | 41.645 | 1.00 | 39.19 | | C |
| ANISOU | 5589 | CB | LEU | B | 372 | 5228 | 5035 | 4627 | −62 | −1071 | 461 | C |
| ATOM | 5590 | CG | LEU | B | 372 | 11.995 | 20.876 | 40.175 | 1.00 | 38.59 | | C |
| ANISOU | 5590 | CG | LEU | B | 372 | 4998 | 5010 | 4653 | −156 | −1037 | 499 | C |
| ATOM | 5591 | CD1 | LEU | B | 372 | 13.357 | 20.287 | 39.914 | 1.00 | 41.68 | | C |
| ANISOU | 5591 | CD1 | LEU | B | 372 | 5299 | 5482 | 5057 | −95 | −1096 | 389 | C |
| ATOM | 5592 | CD2 | LEU | B | 372 | 10.938 | 20.217 | 39.297 | 1.00 | 33.45 | | C |
| ANISOU | 5592 | CD2 | LEU | B | 372 | 4419 | 4309 | 3982 | −216 | −960 | 635 | C |
| ATOM | 5593 | N | LYS | B | 373 | 9.988 | 20.577 | 44.315 | 1.00 | 30.20 | | N |
| ANISOU | 5593 | N | LYS | B | 373 | 4529 | 3699 | 3246 | −79 | −936 | 395 | N |
| ATOM | 5594 | CA | LYS | B | 373 | 9.292 | 19.678 | 45.242 | 1.00 | 36.44 | | C |
| ANISOU | 5594 | CA | LYS | B | 373 | 5615 | 4400 | 3833 | −92 | −859 | 388 | C |
| ATOM | 5595 | C | LYS | B | 373 | 7.870 | 20.174 | 45.457 | 1.00 | 34.44 | | C |
| ANISOU | 5595 | C | LYS | B | 373 | 5361 | 4023 | 3703 | −214 | −601 | 347 | C |
| ATOM | 5596 | O | LYS | B | 373 | 6.932 | 19.394 | 45.540 | 1.00 | 39.87 | | O |
| ANISOU | 5596 | O | LYS | B | 373 | 6172 | 4629 | 4347 | −244 | −461 | 365 | O |
| ATOM | 5597 | CB | LYS | B | 373 | 10.012 | 19.561 | 46.586 | 1.00 | 41.91 | | C |
| ANISOU | 5597 | CB | LYS | B | 373 | 6576 | 5063 | 4285 | −89 | −997 | 310 | C |
| ATOM | 5598 | CG | LYS | B | 373 | 11.447 | 19.067 | 46.491 | 1.00 | 53.25 | | C |
| ANISOU | 5598 | CG | LYS | B | 373 | 7980 | 6566 | 5688 | 44 | −1302 | 317 | C |
| ATOM | 5599 | CD | LYS | B | 373 | 11.609 | 17.801 | 45.682 | 1.00 | 60.05 | | C |
| ANISOU | 5599 | CD | LYS | B | 373 | 8801 | 7456 | 6560 | 150 | −1372 | 398 | C |
| ATOM | 5600 | CE | LYS | B | 373 | 12.968 | 17.178 | 45.982 | 1.00 | 72.54 | | C |
| ANISOU | 5600 | CE | LYS | B | 373 | 10401 | 9026 | 8134 | 275 | −1698 | 358 | C |
| ATOM | 5601 | NZ | LYS | B | 373 | 13.272 | 15.983 | 45.149 | 1.00 | 77.68 | | N |
| ANISOU | 5601 | NZ | LYS | B | 373 | 10956 | 9694 | 8864 | 381 | −1763 | 397 | N |
| ATOM | 5602 | N | SER | B | 374 | 7.720 | 21.484 | 45.524 | 1.00 | 31.39 | | N |
| ANISOU | 5602 | N | SER | B | 374 | 4805 | 3604 | 3518 | −286 | −540 | 274 | N |
| ATOM | 5603 | CA | SER | B | 374 | 6.407 | 22.084 | 45.672 | 1.00 | 36.04 | | C |
| ANISOU | 5603 | CA | SER | B | 374 | 5310 | 4037 | 4347 | −400 | −308 | 195 | C |
| ATOM | 5604 | C | SER | B | 374 | 5.533 | 21.743 | 44.459 | 1.00 | 36.24 | | C |
| ANISOU | 5604 | C | SER | B | 374 | 5158 | 4003 | 4608 | −387 | −295 | 308 | C |
| ATOM | 5605 | O | SER | B | 374 | 4.398 | 21.288 | 44.611 | 1.00 | 27.79 | | O |
| ANISOU | 5605 | O | SER | B | 374 | 4125 | 2798 | 3636 | −437 | −119 | 268 | O |
| ATOM | 5606 | CB | SER | B | 374 | 6.538 | 23.595 | 45.851 | 1.00 | 38.29 | | C |
| ANISOU | 5606 | CB | SER | B | 374 | 5405 | 4289 | 4856 | −464 | −294 | 98 | C |
| ATOM | 5607 | OG | SER | B | 374 | 5.355 | 24.144 | 46.397 | 1.00 | 51.72 | | O |
| ANISOU | 5607 | OG | SER | B | 374 | 7058 | 5803 | 6791 | −588 | −41 | −52 | O |
| ATOM | 5608 | N | ILE | B | 375 | 6.075 | 21.944 | 43.260 | 1.00 | 32.86 | | N |
| ANISOU | 5608 | N | ILE | B | 375 | 4561 | 3660 | 4263 | −343 | −480 | 437 | N |
| ATOM | 5609 | CA | ILE | B | 375 | 5.352 | 21.609 | 42.039 | 1.00 | 31.32 | | C |
| ANISOU | 5609 | CA | ILE | B | 375 | 4258 | 3401 | 4243 | −358 | −524 | 566 | C |
| ATOM | 5610 | C | ILE | B | 375 | 4.934 | 20.137 | 42.048 | 1.00 | 32.80 | | C |
| ANISOU | 5610 | C | ILE | B | 375 | 4617 | 3594 | 4253 | −306 | −455 | 615 | C |
| ATOM | 5611 | O | ILE | B | 375 | 3.779 | 19.813 | 41.780 | 1.00 | 35.48 | | O |
| ANISOU | 5611 | O | ILE | B | 375 | 4921 | 3793 | 4766 | −342 | −370 | 632 | O |
| ATOM | 5612 | CB | ILE | B | 375 | 6.207 | 21.920 | 40.782 | 1.00 | 30.55 | | C |
| ANISOU | 5612 | CB | ILE | B | 375 | 4056 | 3406 | 4145 | −370 | −716 | 690 | C |
| ATOM | 5613 | CG1 | ILE | B | 375 | 6.326 | 23.436 | 40.597 | 1.00 | 29.09 | | C |
| ANISOU | 5613 | CG1 | ILE | B | 375 | 3698 | 3161 | 4193 | −453 | −790 | 665 | C |
| ATOM | 5614 | CG2 | ILE | B | 375 | 5.617 | 21.284 | 39.526 | 1.00 | 23.97 | | C |
| ANISOU | 5614 | CG2 | ILE | B | 375 | 3219 | 2519 | 3369 | −409 | −782 | 840 | C |
| ATOM | 5615 | CD1 | ILE | B | 375 | 7.132 | 23.827 | 39.422 | 1.00 | 27.61 | | C |
| ANISOU | 5615 | CD1 | ILE | B | 375 | 3460 | 3050 | 3981 | −521 | −942 | 767 | C |
| ATOM | 5616 | N | ILE | B | 376 | 5.862 | 19.260 | 42.415 | 1.00 | 29.31 | | N |
| ANISOU | 5616 | N | ILE | B | 376 | 4350 | 3287 | 3500 | −222 | −508 | 624 | N |
| ATOM | 5617 | CA | ILE | B | 376 | 5.600 | 17.825 | 42.448 | 1.00 | 32.45 | | C |
| ANISOU | 5617 | CA | ILE | B | 376 | 4927 | 3691 | 3712 | −166 | −471 | 676 | C |
| ATOM | 5618 | C | ILE | B | 376 | 4.637 | 17.410 | 43.581 | 1.00 | 40.60 | | C |
| ANISOU | 5618 | C | ILE | B | 376 | 6160 | 4594 | 4673 | −223 | −262 | 578 | C |
| ATOM | 5619 | O | ILE | B | 376 | 3.764 | 16.566 | 43.392 | 1.00 | 42.31 | | O |
| ANISOU | 5619 | O | ILE | B | 376 | 6439 | 4735 | 4903 | −233 | −156 | 609 | O |
| ATOM | 5620 | CB | ILE | B | 376 | 6.934 | 17.045 | 42.572 | 1.00 | 28.76 | | C |
| ANISOU | 5620 | CB | ILE | B | 376 | 4572 | 3363 | 2993 | −58 | −632 | 694 | C |
| ATOM | 5621 | CG1 | ILE | B | 376 | 7.777 | 17.250 | 41.314 | 1.00 | 30.94 | | C |
| ANISOU | 5621 | CG1 | ILE | B | 376 | 4650 | 3747 | 3359 | −41 | −753 | 753 | C |
| ATOM | 5622 | CG2 | ILE | B | 376 | 6.703 | 15.554 | 42.809 | 1.00 | 26.19 | | C |
| ANISOU | 5622 | CG2 | ILE | B | 376 | 4464 | 3018 | 2469 | 1 | −618 | 737 | C |
| ATOM | 5623 | CD1 | ILE | B | 376 | 9.082 | 16.509 | 41.366 | 1.00 | 32.75 | | C |
| ANISOU | 5623 | CD1 | ILE | B | 376 | 4910 | 4076 | 3460 | 64 | −892 | 720 | C |
| ATOM | 5624 | N | ALA | B | 377 | 4.800 | 18.005 | 44.757 | 1.00 | 44.39 | | N |
| ANISOU | 5624 | N | ALA | B | 377 | 6762 | 5038 | 5068 | −287 | −183 | 445 | N |
| ATOM | 5625 | CA | ALA | B | 377 | 3.977 | 17.649 | 45.906 | 1.00 | 41.37 | | C |
| ANISOU | 5625 | CA | ALA | B | 377 | 6634 | 4520 | 4565 | −404 | 62 | 317 | C |
| ATOM | 5626 | C | ALA | B | 377 | 2.511 | 18.001 | 45.673 | 1.00 | 39.20 | | C |
| ANISOU | 5626 | C | ALA | B | 377 | 6173 | 4065 | 4654 | −503 | 315 | 226 | C |
| ATOM | 5627 | O | ALA | B | 377 | 1.619 | 17.271 | 46.089 | 1.00 | 41.75 | | O |
| ANISOU | 5627 | O | ALA | B | 377 | 6647 | 4272 | 4944 | −580 | 536 | 156 | O |
| ATOM | 5628 | CB | ALA | B | 377 | 4.493 | 18.336 | 47.156 | 1.00 | 30.35 | | C |
| ANISOU | 5628 | CB | ALA | B | 377 | 5429 | 3109 | 2994 | −496 | 97 | 182 | C |
| ATOM | 5629 | N | LYS | B | 378 | 2.268 | 19.122 | 45.004 | 1.00 | 52.57 | | N |
| ANISOU | 5629 | N | LYS | B | 378 | 8662 | 6059 | 5252 | −586 | −526 | 1676 | N |
| ATOM | 5630 | CA | LYS | B | 378 | 0.907 | 19.598 | 44.798 | 1.00 | 51.35 | | C |
| ANISOU | 5630 | CA | LYS | B | 378 | 8348 | 6008 | 5156 | −722 | −231 | 1694 | C |
| ATOM | 5631 | C | LYS | B | 378 | 0.358 | 19.087 | 43.473 | 1.00 | 48.74 | | C |
| ANISOU | 5631 | C | LYS | B | 378 | 7730 | 5681 | 5107 | −866 | −179 | 1672 | C |
| ATOM | 5632 | O | LYS | B | 378 | −0.753 | 19.420 | 43.082 | 1.00 | 54.25 | | O |
| ANISOU | 5632 | O | LYS | B | 378 | 8234 | 6450 | 5927 | −986 | 15 | 1673 | O |
| ATOM | 5633 | CB | LYS | B | 378 | 0.857 | 21.131 | 44.866 | 1.00 | 56.31 | | C |
| ANISOU | 5633 | CB | LYS | B | 378 | 8849 | 6800 | 5746 | −660 | −221 | 1581 | C |
| ATOM | 5634 | CG | LYS | B | 378 | −0.566 | 21.726 | 44.902 | 1.00 | 69.22 | | C |
| ANISOU | 5634 | CG | LYS | B | 378 | 10351 | 8531 | 7419 | −768 | 94 | 1607 | C |
| ATOM | 5635 | CD | LYS | B | 378 | −0.901 | 22.409 | 46.232 | 1.00 | 75.98 | | C |
| ANISOU | 5635 | CD | LYS | B | 378 | 11466 | 9404 | 8001 | −690 | 253 | 1648 | C |
| ATOM | 5636 | CE | LYS | B | 378 | −2.216 | 23.192 | 46.155 | 1.00 | 68.64 | | C |
| ANISOU | 5636 | CE | LYS | B | 378 | 10341 | 8581 | 7159 | −771 | 561 | 1646 | C |
| ATOM | 5637 | NZ | LYS | B | 378 | −2.375 | 23.911 | 44.871 | 1.00 | 61.58 | | N |
| ANISOU | 5637 | NZ | LYS | B | 378 | 9050 | 7816 | 6532 | −820 | 481 | 1518 | N |
| ATOM | 5638 | N | GLU | B | 379 | 1.141 | 18.255 | 42.796 | 1.00 | 47.64 | | N |
| ANISOU | 5638 | N | GLU | B | 379 | 7576 | 5448 | 5076 | −844 | −365 | 1649 | N |
| ATOM | 5639 | CA | GLU | B | 379 | 0.757 | 17.706 | 41.500 | 1.00 | 45.98 | | C |
| ANISOU | 5639 | CA | GLU | B | 379 | 7154 | 5212 | 5103 | −959 | −361 | 1612 | C |
| ATOM | 5640 | C | GLU | B | 379 | 0.421 | 18.814 | 40.510 | 1.00 | 40.25 | | C |
| ANISOU | 5640 | C | GLU | B | 379 | 6132 | 4645 | 4516 | −986 | −349 | 1484 | C |
| ATOM | 5641 | O | GLU | B | 379 | −0.556 | 18.720 | 39.776 | 1.00 | 42.72 | | O |
| ANISOU | 5641 | O | GLU | B | 379 | 6277 | 4970 | 4983 | −1117 | −254 | 1478 | O |
| ATOM | 5642 | CB | GLU | B | 379 | −0.433 | 16.742 | 41.659 | 1.00 | 38.10 | | C |
| ANISOU | 5642 | CB | GLU | B | 379 | 6201 | 4107 | 4166 | −1130 | −160 | 1742 | C |
| ATOM | 5643 | CG | GLU | B | 379 | −0.091 | 15.550 | 42.510 | 1.00 | 58.33 | | C |
| ANISOU | 5643 | CG | GLU | B | 379 | 9076 | 6487 | 6600 | −1110 | −170 | 1878 | C |
| ATOM | 5644 | CD | GLU | B | 379 | −1.191 | 14.510 | 42.552 | 1.00 | 65.84 | | C |
| ANISOU | 5644 | CD | GLU | B | 379 | 10058 | 7302 | 7658 | −1293 | 25 | 2009 | C |
| ATOM | 5645 | OE1 | GLU | B | 379 | −2.366 | 14.857 | 42.303 | 1.00 | 74.11 | | O |
| ANISOU | 5645 | OE1 | GLU | B | 379 | 10902 | 8408 | 8850 | −1433 | 217 | 2018 | O |
| ATOM | 5646 | OE2 | GLU | B | 379 | −0.872 | 13.343 | 42.843 | 1.00 | 61.62 | | O |
| ANISOU | 5646 | OE2 | GLU | B | 379 | 9742 | 6587 | 7084 | −1297 | −20 | 2103 | O |
| ATOM | 5647 | N | ASN | B | 380 | 1.248 | 19.857 | 40.488 | 1.00 | 44.03 | | N |
| ANISOU | 5647 | N | ASN | B | 380 | 6553 | 5225 | 4950 | −859 | −465 | 1383 | N |
| ATOM | 5648 | CA | ASN | B | 380 | 1.040 | 20.984 | 39.589 | 1.00 | 31.06 | | C |
| ANISOU | 5648 | CA | ASN | B | 380 | 4664 | 3721 | 3417 | −867 | −459 | 1266 | C |
| ATOM | 5649 | C | ASN | B | 380 | 1.404 | 20.628 | 38.149 | 1.00 | 32.30 | | C |
| ANISOU | 5649 | C | ASN | B | 380 | 4689 | 3839 | 3744 | −880 | −558 | 1186 | C |
| ATOM | 5650 | O | ASN | B | 380 | 2.420 | 21.081 | 37.615 | 1.00 | 34.22 | | O |
| ANISOU | 5650 | O | ASN | B | 380 | 4872 | 4102 | 4029 | −777 | −673 | 1096 | O |
| ATOM | 5651 | CB | ASN | B | 380 | 1.840 | 22.199 | 40.056 | 1.00 | 30.31 | | C |
| ANISOU | 5651 | CB | ASN | B | 380 | 4562 | 3722 | 3231 | −734 | −547 | 1188 | C |
| ATOM | 5652 | CG | ASN | B | 380 | 1.393 | 23.491 | 39.370 | 1.00 | 35.81 | | C |
| ANISOU | 5652 | CG | ASN | B | 380 | 5036 | 4562 | 4009 | −750 | −494 | 1091 | C |
| ATOM | 5653 | OD1 | ASN | B | 380 | 0.581 | 23.467 | 38.444 | 1.00 | 28.35 | | O |
| ANISOU | 5653 | OD1 | ASN | B | 380 | 3938 | 3641 | 3191 | −847 | −424 | 1072 | O |
| ATOM | 5654 | ND2 | ASN | B | 380 | 1.938 | 24.621 | 39.814 | 1.00 | 34.37 | | N |
| ANISOU | 5654 | ND2 | ASN | B | 380 | 4846 | 4457 | 3758 | −653 | −553 | 1025 | N |
| ATOM | 5655 | N | MET | B | 381 | 0.559 | 19.801 | 37.543 | 1.00 | 34.50 | | N |
| ANISOU | 5655 | N | MET | B | 381 | 4939 | 4044 | 4127 | −1007 | −504 | 1221 | N |
| ATOM | 5656 | CA | MET | B | 381 | 0.683 | 19.390 | 36.151 | 1.00 | 32.01 | | C |
| ANISOU | 5656 | CA | MET | B | 381 | 4550 | 3668 | 3945 | −1031 | −588 | 1146 | C |
| ATOM | 5657 | C | MET | B | 381 | 0.875 | 20.565 | 35.207 | 1.00 | 31.03 | | C |
| ANISOU | 5657 | C | MET | B | 381 | 4267 | 3656 | 3866 | −979 | −621 | 1025 | C |
| ATOM | 5658 | O | MET | B | 381 | 0.286 | 21.628 | 35.382 | 1.00 | 32.85 | | O |
| ANISOU | 5658 | O | MET | B | 381 | 4381 | 4013 | 4087 | −996 | −556 | 1003 | O |
| ATOM | 5659 | CB | MET | B | 381 | −0.557 | 18.599 | 35.734 | 1.00 | 33.12 | | C |
| ANISOU | 5659 | CB | MET | B | 381 | 4658 | 3726 | 4201 | −1198 | −536 | 1193 | C |
| ATOM | 5660 | CG | MET | B | 381 | −0.730 | 17.321 | 36.542 | 1.00 | 44.99 | | C |
| ANISOU | 5660 | CG | MET | B | 381 | 6331 | 5083 | 5679 | −1263 | −490 | 1322 | C |
| ATOM | 5661 | SD | MET | B | 381 | −2.206 | 16.365 | 36.130 | 1.00 | 57.62 | | S |
| ANISOU | 5661 | SD | MET | B | 381 | 7865 | 6557 | 7473 | −1483 | −427 | 1385 | S |
| ATOM | 5662 | CE | MET | B | 381 | −2.060 | 15.014 | 37.310 | 1.00 | 74.51 | | C |
| ANISOU | 5662 | CE | MET | B | 381 | 10256 | 8522 | 9532 | −1518 | −349 | 1552 | C |
| ATOM | 5663 | N | CYS | B | 382 | 1.696 | 20.352 | 34.191 | 1.00 | 27.36 | | N |
| ANISOU | 5663 | N | CYS | B | 382 | 3815 | 3130 | 3451 | −910 | −705 | 950 | N |
| ATOM | 5664 | CA | CYS | B | 382 | 1.948 | 21.361 | 33.195 | 1.00 | 26.05 | | C |
| ANISOU | 5664 | CA | CYS | B | 382 | 3543 | 3037 | 3320 | −856 | −716 | 846 | C |
| ATOM | 5665 | C | CYS | B | 382 | 1.541 | 20.863 | 31.830 | 1.00 | 33.32 | | C |
| ANISOU | 5665 | C | CYS | B | 382 | 4493 | 3867 | 4301 | −904 | −756 | 793 | C |
| ATOM | 5666 | O | CYS | B | 382 | 1.661 | 19.677 | 31.550 | 1.00 | 31.58 | | O |
| ANISOU | 5666 | O | CYS | B | 382 | 4393 | 3504 | 4102 | −925 | −799 | 812 | O |
| ATOM | 5667 | CB | CYS | B | 382 | 3.423 | 21.736 | 33.197 | 1.00 | 25.49 | | C |
| ANISOU | 5667 | CB | CYS | B | 382 | 3471 | 2961 | 3252 | −706 | −751 | 799 | C |
| ATOM | 5668 | SG | CYS | B | 382 | 3.900 | 23.019 | 31.989 | 1.00 | 31.36 | | S |
| ANISOU | 5668 | SG | CYS | B | 382 | 4101 | 3770 | 4045 | −632 | −719 | 686 | S |
| ATOM | 5669 | N | VAL | B | 383 | 1.043 | 21.758 | 30.980 | 1.00 | 25.49 | | N |
| ANISOU | 5669 | N | VAL | B | 383 | 3419 | 2941 | 3326 | −917 | −760 | 723 | N |
| ATOM | 5670 | CA | VAL | B | 383 | 0.847 | 21.420 | 29.571 | 1.00 | 25.77 | | C |
| ANISOU | 5670 | CA | VAL | B | 383 | 3536 | 2874 | 3380 | −926 | −827 | 654 | C |
| ATOM | 5671 | C | VAL | B | 383 | 1.364 | 22.551 | 28.716 | 1.00 | 33.96 | | C |
| ANISOU | 5671 | C | VAL | B | 383 | 4555 | 3967 | 4382 | −827 | −800 | 572 | C |
| ATOM | 5672 | O | VAL | B | 383 | 1.500 | 23.688 | 29.179 | 1.00 | 34.09 | | O |
| ANISOU | 5672 | O | VAL | B | 383 | 4449 | 4113 | 4389 | −792 | −747 | 568 | O |
| ATOM | 5673 | CB | VAL | B | 383 | −0.626 | 21.152 | 29.196 | 1.00 | 26.68 | | C |
| ANISOU | 5673 | CB | VAL | B | 383 | 3613 | 2957 | 3567 | −1070 | −905 | 657 | C |
| ATOM | 5674 | CG1 | VAL | B | 383 | −1.224 | 19.942 | 30.003 | 1.00 | 28.07 | | C |
| ANISOU | 5674 | CG1 | VAL | B | 383 | 3806 | 3048 | 3812 | −1192 | −905 | 752 | C |
| ATOM | 5675 | CG2 | VAL | B | 383 | −1.445 | 22.425 | 29.362 | 1.00 | 26.10 | | C |
| ANISOU | 5675 | CG2 | VAL | B | 383 | 3362 | 3031 | 3522 | −1100 | −881 | 645 | C |
| ATOM | 5676 | N | LYS | B | 384 | 1.649 | 22.246 | 27.457 | 1.00 | 30.64 | | N |
| ANISOU | 5676 | N | LYS | B | 384 | 4281 | 3431 | 3931 | −779 | −828 | 507 | N |
| ATOM | 5677 | CA | LYS | B | 384 | 2.145 | 23.264 | 26.565 | 1.00 | 31.26 | | C |
| ANISOU | 5677 | CA | LYS | B | 384 | 4383 | 3533 | 3961 | −683 | −772 | 440 | C |
| ATOM | 5678 | C | LYS | B | 384 | 1.110 | 23.686 | 25.532 | 1.00 | 31.00 | | C |
| ANISOU | 5678 | C | LYS | B | 384 | 4414 | 3480 | 3884 | −727 | −871 | 387 | C |
| ATOM | 5679 | O | LYS | B | 384 | 0.276 | 22.880 | 25.101 | 1.00 | 26.00 | | O |
| ANISOU | 5679 | O | LYS | B | 384 | 3870 | 2748 | 3261 | −808 | −1003 | 376 | O |
| ATOM | 5680 | CB | LYS | B | 384 | 3.422 | 22.775 | 25.888 | 1.00 | 34.69 | | C |
| ANISOU | 5680 | CB | LYS | B | 384 | 4964 | 3840 | 4377 | −558 | −684 | 407 | C |
| ATOM | 5681 | CG | LYS | B | 384 | 4.633 | 22.831 | 26.823 | 1.00 | 35.42 | | C |
| ANISOU | 5681 | CG | LYS | B | 384 | 4939 | 3968 | 4552 | −479 | −596 | 444 | C |
| ATOM | 5682 | CD | LYS | B | 384 | 5.904 | 22.295 | 26.186 | 1.00 | 35.36 | | C |
| ANISOU | 5682 | CD | LYS | B | 384 | 5032 | 3819 | 4584 | −349 | −489 | 414 | C |
| ATOM | 5683 | CE | LYS | B | 384 | 7.108 | 22.489 | 27.098 | 1.00 | 34.22 | | C |
| ANISOU | 5683 | CE | LYS | B | 384 | 4724 | 3704 | 4575 | −266 | −438 | 443 | C |
| ATOM | 5684 | NZ | LYS | B | 384 | 8.211 | 21.546 | 26.783 | 1.00 | 42.52 | | N |
| ANISOU | 5684 | NZ | LYS | B | 384 | 5845 | 4596 | 5715 | −154 | −368 | 434 | N |
| ATOM | 5685 | N | ILE | B | 385 | 1.154 | 24.966 | 25.157 | 1.00 | 24.19 | | N |
| ANISOU | 5685 | N | ILE | B | 385 | 3506 | 2697 | 2986 | −675 | −829 | 355 | N |
| ATOM | 5686 | CA | ILE | B | 385 | 0.328 | 25.443 | 24.054 | 1.00 | 32.28 | | C |
| ANISOU | 5686 | CA | ILE | B | 385 | 4633 | 3680 | 3950 | −683 | −939 | 300 | C |
| ATOM | 5687 | C | ILE | B | 385 | 1.208 | 25.912 | 22.883 | 1.00 | 32.74 | | C |
| ANISOU | 5687 | C | ILE | B | 385 | 4901 | 3652 | 3885 | −551 | −841 | 248 | C |
| ATOM | 5688 | O | ILE | B | 385 | 2.312 | 25.404 | 22.697 | 1.00 | 35.57 | | O |
| ANISOU | 5688 | O | ILE | B | 385 | 5361 | 3929 | 4225 | −470 | −708 | 246 | O |
| ATOM | 5689 | CB | ILE | B | 385 | −0.629 | 26.560 | 24.495 | 1.00 | 36.21 | | C |
| ANISOU | 5689 | CB | ILE | B | 385 | 4932 | 4321 | 4506 | −736 | −989 | 310 | C |
| ATOM | 5690 | CG1 | ILE | B | 385 | 0.118 | 27.728 | 25.159 | 1.00 | 32.70 | | C |
| ANISOU | 5690 | CG1 | ILE | B | 385 | 4350 | 4010 | 4067 | −669 | −837 | 327 | C |
| ATOM | 5691 | CG2 | ILE | B | 385 | −1.699 | 26.000 | 25.428 | 1.00 | 24.62 | | C |
| ANISOU | 5691 | CG2 | ILE | B | 385 | 3291 | 2898 | 3165 | −870 | −1067 | 360 | C |
| ATOM | 5692 | CD1 | ILE | B | 385 | −0.830 | 28.792 | 25.656 | 1.00 | 22.41 | | C |
| ANISOU | 5692 | CD1 | ILE | B | 385 | 2863 | 2836 | 2817 | −710 | −874 | 333 | C |
| ATOM | 5693 | N | VAL | B | 386 | 0.709 | 26.836 | 22.073 | 1.00 | 38.07 | | N |
| ANISOU | 5693 | N | VAL | B | 386 | 5654 | 4326 | 4484 | −525 | −897 | 211 | N |
| ATOM | 5694 | CA | VAL | B | 386 | 1.423 | 27.289 | 20.878 | 1.00 | 41.22 | | C |
| ANISOU | 5694 | CA | VAL | B | 386 | 6305 | 4618 | 4738 | −400 | −787 | 171 | C |
| ATOM | 5695 | C | VAL | B | 386 | 2.839 | 27.742 | 21.222 | 1.00 | 44.97 | | C |
| ANISOU | 5695 | C | VAL | B | 386 | 6696 | 5127 | 5265 | −313 | −523 | 199 | C |
| ATOM | 5696 | O | VAL | B | 386 | 3.089 | 28.238 | 22.327 | 1.00 | 35.11 | | O |
| ANISOU | 5696 | O | VAL | B | 386 | 5182 | 4017 | 4143 | −343 | −474 | 237 | O |
| ATOM | 5697 | CB | VAL | B | 386 | 0.658 | 28.431 | 20.173 | 1.00 | 41.96 | | C |
| ANISOU | 5697 | CB | VAL | B | 386 | 6468 | 4726 | 4749 | −383 | −888 | 143 | C |
| ATOM | 5698 | CG1 | VAL | B | 386 | 1.407 | 28.938 | 18.962 | 1.00 | 41.99 | | C |
| ANISOU | 5698 | CG1 | VAL | B | 386 | 6771 | 4604 | 4578 | −250 | −742 | 118 | C |
| ATOM | 5699 | CG2 | VAL | B | 386 | −0.688 | 27.939 | 19.736 | 1.00 | 50.84 | | C |
| ANISOU | 5699 | CG2 | VAL | B | 386 | 7670 | 5784 | 5861 | −460 | −1182 | 106 | C |
| ATOM | 5700 | N | ASP | B | 387 | 3.753 | 27.556 | 20.268 | 1.00 | 56.56 | | N |
| ANISOU | 5700 | N | ASP | B | 387 | 8397 | 6451 | 6644 | −201 | −356 | 178 | N |
| ATOM | 5701 | CA | ASP | B | 387 | 5.191 | 27.803 | 20.435 | 1.00 | 60.62 | | C |
| ANISOU | 5701 | CA | ASP | B | 387 | 8829 | 6947 | 7257 | −111 | −87 | 201 | C |
| ATOM | 5702 | C | ASP | B | 387 | 5.750 | 27.328 | 21.773 | 1.00 | 53.13 | | C |
| ANISOU | 5702 | C | ASP | B | 387 | 7600 | 6086 | 6502 | −148 | −81 | 240 | C |
| ATOM | 5703 | O | ASP | B | 387 | 6.563 | 28.020 | 22.373 | 1.00 | 47.74 | | O |
| ANISOU | 5703 | O | ASP | B | 387 | 6712 | 5467 | 5959 | −120 | 35 | 263 | O |
| ATOM | 5704 | CB | ASP | B | 387 | 5.498 | 29.303 | 20.287 | 1.00 | 63.42 | | C |
| ANISOU | 5704 | CB | ASP | B | 387 | 9107 | 7361 | 7631 | −75 | 43 | 215 | C |
| ATOM | 5705 | CG | ASP | B | 387 | 4.831 | 29.932 | 19.074 | 1.00 | 71.06 | | C |
| ANISOU | 5705 | CG | ASP | B | 387 | 10357 | 8250 | 8391 | −38 | 4 | 187 | C |
| ATOM | 5706 | OD1 | ASP | B | 387 | 5.110 | 29.479 | 17.935 | 1.00 | 67.30 | | O |
| ANISOU | 5706 | OD1 | ASP | B | 387 | 10215 | 7601 | 7756 | 49 | 96 | 161 | O |
| ATOM | 5707 | OD2 | ASP | B | 387 | 4.043 | 30.896 | 19.269 | 1.00 | 73.90 | | O |
| ANISOU | 5707 | OD2 | ASP | B | 387 | 10624 | 8712 | 8742 | −85 | −120 | 190 | O |
| ATOM | 5708 | N | GLY | B | 388 | 5.319 | 26.149 | 22.221 | 1.00 | 45.27 | | N |
| ANISOU | 5708 | N | GLY | B | 388 | 6614 | 5072 | 5513 | −208 | −221 | 246 | N |
| ATOM | 5709 | CA | GLY | B | 388 | 5.873 | 25.516 | 23.403 | 1.00 | 30.75 | | C |
| ANISOU | 5709 | CA | GLY | B | 388 | 4586 | 3276 | 3821 | −225 | −227 | 287 | C |
| ATOM | 5710 | C | GLY | B | 388 | 5.730 | 26.270 | 24.717 | 1.00 | 33.67 | | C |
| ANISOU | 5710 | C | GLY | B | 388 | 4684 | 3819 | 4289 | −285 | −284 | 326 | C |
| ATOM | 5711 | O | GLY | B | 388 | 6.486 | 26.029 | 25.664 | 1.00 | 39.10 | | O |
| ANISOU | 5711 | O | GLY | B | 388 | 5230 | 4529 | 5096 | −264 | −270 | 356 | O |
| ATOM | 5712 | N | VAL | B | 389 | 4.757 | 27.173 | 24.792 | 1.00 | 29.57 | | N |
| ANISOU | 5712 | N | VAL | B | 389 | 4109 | 3408 | 3717 | −350 | −362 | 322 | N |
| ATOM | 5713 | CA | VAL | B | 389 | 4.503 | 27.933 | 26.019 | 1.00 | 25.27 | | C |
| ANISOU | 5713 | CA | VAL | B | 389 | 3346 | 3020 | 3238 | −399 | −407 | 351 | C |
| ATOM | 5714 | C | VAL | B | 389 | 3.881 | 27.069 | 27.132 | 1.00 | 30.60 | | C |
| ANISOU | 5714 | C | VAL | B | 389 | 3959 | 3741 | 3927 | −486 | −517 | 398 | C |
| ATOM | 5715 | O | VAL | B | 389 | 2.904 | 26.353 | 26.893 | 1.00 | 31.68 | | O |
| ANISOU | 5715 | O | VAL | B | 389 | 4171 | 3844 | 4022 | −563 | −607 | 405 | O |
| ATOM | 5716 | CB | VAL | B | 389 | 3.591 | 29.127 | 25.706 | 1.00 | 25.53 | | C |
| ANISOU | 5716 | CB | VAL | B | 389 | 3347 | 3137 | 3215 | −430 | −444 | 330 | C |
| ATOM | 5717 | CG1 | VAL | B | 389 | 2.974 | 29.698 | 26.975 | 1.00 | 27.39 | | C |
| ANISOU | 5717 | CG1 | VAL | B | 389 | 3394 | 3521 | 3490 | −492 | −503 | 356 | C |
| ATOM | 5718 | CG2 | VAL | B | 389 | 4.364 | 30.175 | 24.899 | 1.00 | 21.30 | | C |
| ANISOU | 5718 | CG2 | VAL | B | 389 | 2852 | 2563 | 2679 | −342 | −307 | 303 | C |
| ATOM | 5719 | N | GLN | B | 390 | 4.440 | 27.144 | 28.343 | 1.00 | 24.84 | | N |
| ANISOU | 5719 | N | GLN | B | 390 | 3108 | 3072 | 3260 | −473 | −515 | 432 | N |
| ATOM | 5720 | CA | GLN | B | 390 | 4.042 | 26.237 | 29.424 | 1.00 | 27.68 | | C |
| ANISOU | 5720 | CA | GLN | B | 390 | 3462 | 3445 | 3611 | −535 | −587 | 490 | C |
| ATOM | 5721 | C | GLN | B | 390 | 2.875 | 26.795 | 30.233 | 1.00 | 30.27 | | C |
| ANISOU | 5721 | C | GLN | B | 390 | 3703 | 3897 | 3901 | −620 | −617 | 518 | C |
| ATOM | 5722 | O | GLN | B | 390 | 2.828 | 27.992 | 30.543 | 1.00 | 32.68 | | O |
| ANISOU | 5722 | O | GLN | B | 390 | 3912 | 4301 | 4204 | −599 | −593 | 496 | O |
| ATOM | 5723 | CB | GLN | B | 390 | 5.222 | 25.944 | 30.371 | 1.00 | 22.17 | | C |
| ANISOU | 5723 | CB | GLN | B | 390 | 2724 | 2723 | 2977 | −464 | −597 | 516 | C |
| ATOM | 5724 | CG | GLN | B | 390 | 6.500 | 25.453 | 29.700 | 1.00 | 26.53 | | C |
| ANISOU | 5724 | CG | GLN | B | 390 | 3309 | 3146 | 3624 | −362 | −544 | 490 | C |
| ATOM | 5725 | CD | GLN | B | 390 | 7.418 | 26.623 | 29.281 | 1.00 | 33.65 | | C |
| ANISOU | 5725 | CD | GLN | B | 390 | 4099 | 4059 | 4628 | −282 | −454 | 443 | C |
| ATOM | 5726 | OE1 | GLN | B | 390 | 7.025 | 27.793 | 29.346 | 1.00 | 29.21 | | O |
| ANISOU | 5726 | OE1 | GLN | B | 390 | 3463 | 3595 | 4040 | −308 | −443 | 424 | O |
| ATOM | 5727 | NE2 | GLN | B | 390 | 8.637 | 26.301 | 28.858 | 1.00 | 24.02 | | N |
| ANISOU | 5727 | NE2 | GLN | B | 390 | 2858 | 2724 | 3544 | −186 | −377 | 427 | N |
| ATOM | 5728 | N | CYS | B | 391 | 1.958 | 25.904 | 30.601 | 1.00 | 31.07 | | N |
| ANISOU | 5728 | N | CYS | B | 391 | 3837 | 3978 | 3988 | −714 | −652 | 569 | N |
| ATOM | 5729 | CA | CYS | B | 391 | 0.773 | 26.248 | 31.378 | 1.00 | 22.47 | | C |
| ANISOU | 5729 | CA | CYS | B | 391 | 2660 | 2983 | 2894 | −798 | −637 | 608 | C |
| ATOM | 5730 | C | CYS | B | 391 | 0.682 | 25.277 | 32.556 | 1.00 | 31.81 | | C |
| ANISOU | 5730 | C | CYS | B | 391 | 3897 | 4137 | 4054 | −842 | −619 | 694 | C |
| ATOM | 5731 | O | CYS | B | 391 | 0.665 | 24.057 | 32.362 | 1.00 | 34.70 | | O |
| ANISOU | 5731 | O | CYS | B | 391 | 4354 | 4390 | 4439 | −885 | −651 | 729 | O |
| ATOM | 5732 | CB | CYS | B | 391 | −0.491 | 26.151 | 30.527 | 1.00 | 22.93 | | C |
| ANISOU | 5732 | CB | CYS | B | 391 | 2688 | 3020 | 3004 | −888 | −683 | 591 | C |
| ATOM | 5733 | SG | CYS | B | 391 | −0.482 | 27.121 | 29.021 | 1.00 | 32.72 | | S |
| ANISOU | 5733 | SG | CYS | B | 391 | 3946 | 4253 | 4233 | −831 | −734 | 498 | S |
| ATOM | 5734 | N | TRP | B | 392 | 0.631 | 25.814 | 33.770 | 1.00 | 26.02 | | N |
| ANISOU | 5734 | N | TRP | B | 392 | 3138 | 3487 | 3262 | −826 | −568 | 730 | N |
| ATOM | 5735 | CA | TRP | B | 392 | 0.536 | 25.000 | 34.983 | 1.00 | 28.12 | | C |
| ANISOU | 5735 | CA | TRP | B | 392 | 3503 | 3717 | 3464 | −854 | −534 | 822 | C |
| ATOM | 5736 | C | TRP | B | 392 | −0.872 | 25.078 | 35.571 | 1.00 | 30.70 | | C |
| ANISOU | 5736 | C | TRP | B | 392 | 3774 | 4092 | 3800 | −956 | −415 | 883 | C |
| ATOM | 5737 | O | TRP | B | 392 | −1.584 | 26.059 | 35.359 | 1.00 | 30.72 | | O |
| ANISOU | 5737 | O | TRP | B | 392 | 3644 | 4185 | 3843 | −970 | −369 | 844 | O |
| ATOM | 5738 | CB | TRP | B | 392 | 1.549 | 25.471 | 36.027 | 1.00 | 24.62 | | C |
| ANISOU | 5738 | CB | TRP | B | 392 | 3127 | 3302 | 2923 | −745 | −567 | 823 | C |
| ATOM | 5739 | CG | TRP | B | 392 | 3.009 | 25.177 | 35.734 | 1.00 | 29.85 | | C |
| ANISOU | 5739 | CG | TRP | B | 392 | 3828 | 3888 | 3626 | −644 | −680 | 786 | C |
| ATOM | 5740 | CD1 | TRP | B | 392 | 3.746 | 24.113 | 36.192 | 1.00 | 25.27 | | C |
| ANISOU | 5740 | CD1 | TRP | B | 392 | 3372 | 3197 | 3032 | −603 | −753 | 834 | C |
| ATOM | 5741 | CD2 | TRP | B | 392 | 3.908 | 25.980 | 34.963 | 1.00 | 23.36 | | C |
| ANISOU | 5741 | CD2 | TRP | B | 392 | 2907 | 3080 | 2890 | −565 | −718 | 698 | C |
| ATOM | 5742 | NE1 | TRP | B | 392 | 5.035 | 24.198 | 35.735 | 1.00 | 24.96 | | N |
| ANISOU | 5742 | NE1 | TRP | B | 392 | 3289 | 3105 | 3090 | −500 | −837 | 777 | N |
| ATOM | 5743 | CE2 | TRP | B | 392 | 5.158 | 25.326 | 34.970 | 1.00 | 23.84 | | C |
| ANISOU | 5743 | CE2 | TRP | B | 392 | 3008 | 3035 | 3015 | −481 | −800 | 696 | C |
| ATOM | 5744 | CE3 | TRP | B | 392 | 3.770 | 27.166 | 34.244 | 1.00 | 22.34 | | C |
| ANISOU | 5744 | CE3 | TRP | B | 392 | 2659 | 3027 | 2802 | −556 | −679 | 628 | C |
| ATOM | 5745 | CZ2 | TRP | B | 392 | 6.276 | 25.847 | 34.305 | 1.00 | 28.94 | | C |
| ANISOU | 5745 | CZ2 | TRP | B | 392 | 3555 | 3651 | 3791 | −394 | −818 | 627 | C |
| ATOM | 5746 | CZ3 | TRP | B | 392 | 4.879 | 27.679 | 33.573 | 1.00 | 22.49 | | C |
| ANISOU | 5746 | CZ3 | TRP | B | 392 | 2612 | 3012 | 2920 | −475 | −696 | 565 | C |
| ATOM | 5747 | CH2 | TRP | B | 392 | 6.118 | 27.021 | 33.618 | 1.00 | 24.90 | | C |
| ANISOU | 5747 | CH2 | TRP | B | 392 | 2936 | 3212 | 3313 | −397 | −752 | 566 | C |
| ATOM | 5748 | N | LYS | B | 393 | −1.267 | 24.063 | 36.328 | 1.00 | 27.00 | | N |
| ANISOU | 5748 | N | LYS | B | 393 | 3402 | 3550 | 3307 | −1022 | −350 | 983 | N |
| ATOM | 5749 | CA | LYS | B | 393 | −2.565 | 24.067 | 36.991 | 1.00 | 28.35 | | C |
| ANISOU | 5749 | CA | LYS | B | 393 | 3515 | 3744 | 3512 | −1119 | −186 | 1058 | C |
| ATOM | 5750 | C | LYS | B | 393 | −2.673 | 25.141 | 38.072 | 1.00 | 37.28 | | C |
| ANISOU | 5750 | C | LYS | B | 393 | 4665 | 4982 | 4517 | −1049 | −68 | 1062 | C |
| ATOM | 5751 | O | LYS | B | 393 | −3.720 | 25.772 | 38.239 | 1.00 | 34.93 | | O |
| ANISOU | 5751 | O | LYS | B | 393 | 4237 | 4749 | 4283 | −1091 | 68 | 1068 | O |
| ATOM | 5752 | CB | LYS | B | 393 | −2.843 | 22.703 | 37.618 | 1.00 | 46.02 | | C |
| ANISOU | 5752 | CB | LYS | B | 393 | 5888 | 5855 | 5743 | −1202 | −115 | 1179 | C |
| ATOM | 5753 | CG | LYS | B | 393 | −3.385 | 21.663 | 36.649 | 1.00 | 49.82 | | C |
| ANISOU | 5753 | CG | LYS | B | 393 | 6307 | 6219 | 6402 | −1326 | −178 | 1188 | C |
| ATOM | 5754 | CD | LYS | B | 393 | −3.685 | 20.356 | 37.364 | 1.00 | 51.51 | | C |
| ANISOU | 5754 | CD | LYS | B | 393 | 6658 | 6294 | 6619 | −1416 | −88 | 1319 | C |
| ATOM | 5755 | CE | LYS | B | 393 | −4.934 | 20.478 | 38.214 | 1.00 | 52.75 | | C |
| ANISOU | 5755 | CE | LYS | B | 393 | 6736 | 6465 | 6842 | −1517 | 153 | 1418 | C |
| ATOM | 5756 | NZ | LYS | B | 393 | −5.380 | 19.162 | 38.746 | 1.00 | 58.63 | | N |
| ANISOU | 5756 | NZ | LYS | B | 393 | 7593 | 7047 | 7638 | −1635 | 264 | 1555 | N |
| ATOM | 5757 | N | TYR | B | 394 | −1.580 | 25.347 | 38.799 | 1.00 | 35.29 | | N |
| ANISOU | 5757 | N | TYR | B | 394 | 4578 | 4733 | 4097 | −934 | −136 | 1054 | N |
| ATOM | 5758 | CA | TYR | B | 394 | −1.571 | 26.244 | 39.950 | 1.00 | 28.88 | | C |
| ANISOU | 5758 | CA | TYR | B | 394 | 3860 | 3989 | 3123 | −854 | −54 | 1056 | C |
| ATOM | 5759 | C | TYR | B | 394 | −0.422 | 27.241 | 39.907 | 1.00 | 33.99 | | C |
| ANISOU | 5759 | C | TYR | B | 394 | 4516 | 4689 | 3712 | −727 | −217 | 951 | C |
| ATOM | 5760 | O | TYR | B | 394 | 0.580 | 27.001 | 39.239 | 1.00 | 26.62 | | O |
| ANISOU | 5760 | O | TYR | B | 394 | 3559 | 3714 | 2843 | −689 | −378 | 904 | O |
| ATOM | 5761 | CB | TYR | B | 394 | −1.471 | 25.443 | 41.240 | 1.00 | 30.82 | | C |
| ANISOU | 5761 | CB | TYR | B | 394 | 4372 | 4148 | 3189 | −839 | 19 | 1168 | C |
| ATOM | 5762 | CG | TYR | B | 394 | −2.380 | 24.245 | 41.317 | 1.00 | 36.23 | | C |
| ANISOU | 5762 | CG | TYR | B | 394 | 5078 | 4740 | 3947 | −970 | 173 | 1289 | C |
| ATOM | 5763 | CD1 | TYR | B | 394 | −3.762 | 24.400 | 41.384 | 1.00 | 37.74 | | C |
| ANISOU | 5763 | CD1 | TYR | B | 394 | 5128 | 4959 | 4252 | −1073 | 406 | 1337 | C |
| ATOM | 5764 | CD2 | TYR | B | 394 | −1.860 | 22.952 | 41.364 | 1.00 | 39.04 | | C |
| ANISOU | 5764 | CD2 | TYR | B | 394 | 5586 | 4963 | 4283 | −991 | 90 | 1359 | C |
| ATOM | 5765 | CE1 | TYR | B | 394 | −4.609 | 23.290 | 41.476 | 1.00 | 39.20 | | C |
| ANISOU | 5765 | CE1 | TYR | B | 394 | 5307 | 5036 | 4550 | −1209 | 555 | 1455 | C |
| ATOM | 5766 | CE2 | TYR | B | 394 | −2.698 | 21.837 | 41.463 | 1.00 | 34.69 | | C |
| ANISOU | 5766 | CE2 | TYR | B | 394 | 5063 | 4306 | 3813 | −1122 | 234 | 1476 | C |
| ATOM | 5767 | CZ | TYR | B | 394 | −4.067 | 22.018 | 41.511 | 1.00 | 35.80 | | C |
| ANISOU | 5767 | CZ | TYR | B | 394 | 5045 | 4471 | 4085 | −1238 | 467 | 1524 | C |
| ATOM | 5768 | OH | TYR | B | 394 | −4.900 | 20.935 | 41.597 | 1.00 | 53.65 | | O |
| ANISOU | 5768 | OH | TYR | B | 394 | 7302 | 6609 | 6473 | −1382 | 613 | 1641 | O |
| ATOM | 5769 | N | LEU | B | 395 | −0.568 | 28.353 | 40.628 | 1.00 | 32.02 | | N |
| ANISOU | 5769 | N | LEU | B | 395 | 4297 | 4513 | 3356 | −662 | −163 | 915 | N |
| ATOM | 5770 | CA | LEU | B | 395 | 0.517 | 29.323 | 40.761 | 1.00 | 30.28 | | C |
| ANISOU | 5770 | CA | LEU | B | 395 | 4098 | 4319 | 3088 | −548 | −328 | 818 | C |
| ATOM | 5771 | C | LEU | B | 395 | 1.581 | 28.846 | 41.749 | 1.00 | 36.01 | | C |
| ANISOU | 5771 | C | LEU | B | 395 | 5062 | 4955 | 3665 | −460 | −480 | 843 | C |
| ATOM | 5772 | O | LEU | B | 395 | 2.727 | 29.289 | 41.699 | 1.00 | 37.64 | | O |
| ANISOU | 5772 | O | LEU | B | 395 | 5258 | 5139 | 3906 | −377 | −677 | 768 | O |
| ATOM | 5773 | CB | LEU | B | 395 | −0.024 | 30.674 | 41.215 | 1.00 | 36.41 | | C |
| ANISOU | 5773 | CB | LEU | B | 395 | 4850 | 5186 | 3799 | −504 | −237 | 763 | C |
| ATOM | 5774 | CG | LEU | B | 395 | −0.907 | 31.421 | 40.231 | 1.00 | 38.22 | | C |
| ANISOU | 5774 | CG | LEU | B | 395 | 4834 | 5500 | 4189 | −557 | −144 | 716 | C |
| ATOM | 5775 | CD1 | LEU | B | 395 | −1.445 | 32.653 | 40.919 | 1.00 | 38.39 | | C |
| ANISOU | 5775 | CD1 | LEU | B | 395 | 4872 | 5590 | 4123 | −497 | −39 | 672 | C |
| ATOM | 5776 | CD2 | LEU | B | 395 | −0.096 | 31.785 | 38.991 | 1.00 | 36.18 | | C |
| ANISOU | 5776 | CD2 | LEU | B | 395 | 4428 | 5244 | 4074 | −545 | −302 | 635 | C |
| ATOM | 5777 | N | GLU | B | 396 | 1.185 | 27.934 | 42.635 | 1.00 | 40.30 | | N |
| ANISOU | 5777 | N | GLU | B | 396 | 5819 | 5431 | 4063 | −478 | −391 | 951 | N |
| ATOM | 5778 | CA | GLU | B | 396 | 2.038 | 27.433 | 43.710 | 1.00 | 43.85 | | C |
| ANISOU | 5778 | CA | GLU | B | 396 | 6555 | 5776 | 4329 | −385 | −539 | 990 | C |
| ATOM | 5779 | C | GLU | B | 396 | 3.260 | 26.635 | 43.237 | 1.00 | 42.00 | | C |
| ANISOU | 5779 | C | GLU | B | 396 | 6298 | 5447 | 4212 | −349 | −774 | 979 | C |
| ATOM | 5780 | O | GLU | B | 396 | 3.151 | 25.728 | 42.415 | 1.00 | 38.12 | | O |
| ANISOU | 5780 | O | GLU | B | 396 | 5704 | 4919 | 3859 | −422 | −740 | 1016 | O |
| ATOM | 5781 | CB | GLU | B | 396 | 1.216 | 26.566 | 44.663 | 1.00 | 50.61 | | C |
| ANISOU | 5781 | CB | GLU | B | 396 | 7663 | 6565 | 5002 | −424 | −344 | 1129 | C |
| ATOM | 5782 | CG | GLU | B | 396 | 2.057 | 25.942 | 45.773 | 1.00 | 62.16 | | C |
| ANISOU | 5782 | CG | GLU | B | 396 | 9477 | 7895 | 6244 | −320 | −512 | 1183 | C |
| ATOM | 5783 | CD | GLU | B | 396 | 1.229 | 25.212 | 46.819 | 1.00 | 71.11 | | C |
| ANISOU | 5783 | CD | GLU | B | 396 | 10919 | 8948 | 7150 | −346 | −282 | 1331 | C |
| ATOM | 5784 | OE1 | GLU | B | 396 | 0.004 | 25.454 | 46.901 | 1.00 | 72.41 | | O |
| ANISOU | 5784 | OE1 | GLU | B | 396 | 11026 | 9171 | 7315 | −425 | 30 | 1377 | O |
| ATOM | 5785 | OE2 | GLU | B | 396 | 1.811 | 24.381 | 47.555 | 1.00 | 74.14 | | O |
| ANISOU | 5785 | OE2 | GLU | B | 396 | 11603 | 9196 | 7369 | −282 | −407 | 1405 | O |
| ATOM | 5786 | N | GLY | B | 397 | 4.429 | 26.986 | 43.763 | 1.00 | 40.45 | | N |
| ANISOU | 5786 | N | GLY | B | 397 | 6194 | 5197 | 3978 | −229 | −1022 | 921 | N |
| ATOM | 5787 | CA | GLY | B | 397 | 5.644 | 26.291 | 43.392 | 1.00 | 35.83 | | C |
| ANISOU | 5787 | CA | GLY | B | 397 | 5563 | 4511 | 3541 | −175 | −1244 | 906 | C |
| ATOM | 5788 | C | GLY | B | 397 | 6.437 | 27.061 | 42.348 | 1.00 | 38.47 | | C |
| ANISOU | 5788 | C | GLY | B | 397 | 5601 | 4885 | 4132 | −155 | −1338 | 790 | C |
| ATOM | 5789 | O | GLY | B | 397 | 7.642 | 26.865 | 42.222 | 1.00 | 37.56 | | O |
| ANISOU | 5789 | O | GLY | B | 397 | 5425 | 4682 | 4166 | −78 | −1543 | 751 | O |
| ATOM | 5790 | N | LEU | B | 398 | 5.763 | 27.910 | 41.572 | 1.00 | 28.31 | | N |
| ANISOU | 5790 | N | LEU | B | 398 | 4126 | 3715 | 2917 | −223 | −1177 | 741 | N |
| ATOM | 5791 | CA | LEU | B | 398 | 6.461 | 28.730 | 40.601 | 1.00 | 26.98 | | C |
| ANISOU | 5791 | CA | LEU | B | 398 | 3710 | 3573 | 2968 | −204 | −1230 | 642 | C |
| ATOM | 5792 | C | LEU | B | 398 | 7.274 | 29.817 | 41.316 | 1.00 | 28.61 | | C |
| ANISOU | 5792 | C | LEU | B | 398 | 3927 | 3765 | 3178 | −114 | −1419 | 559 | C |
| ATOM | 5793 | O | LEU | B | 398 | 6.827 | 30.378 | 42.317 | 1.00 | 28.50 | | O |
| ANISOU | 5793 | O | LEU | B | 398 | 4084 | 3781 | 2965 | −88 | −1430 | 554 | O |
| ATOM | 5794 | CB | LEU | B | 398 | 5.486 | 29.342 | 39.598 | 1.00 | 31.72 | | C |
| ANISOU | 5794 | CB | LEU | B | 398 | 4148 | 4284 | 3619 | −292 | −1029 | 618 | C |
| ATOM | 5795 | CG | LEU | B | 398 | 5.038 | 28.477 | 38.404 | 1.00 | 37.81 | | C |
| ANISOU | 5795 | CG | LEU | B | 398 | 4833 | 5043 | 4490 | −372 | −913 | 653 | C |
| ATOM | 5796 | CD1 | LEU | B | 398 | 6.224 | 28.020 | 37.544 | 1.00 | 40.33 | | C |
| ANISOU | 5796 | CD1 | LEU | B | 398 | 5058 | 5270 | 4995 | −324 | −995 | 621 | C |
| ATOM | 5797 | CD2 | LEU | B | 398 | 4.196 | 27.286 | 38.821 | 1.00 | 27.63 | | C |
| ANISOU | 5797 | CD2 | LEU | B | 398 | 3688 | 3720 | 3091 | −440 | −831 | 756 | C |
| ATOM | 5798 | N | PRO | B | 399 | 8.499 | 30.070 | 40.831 | 1.00 | 30.63 | | N |
| ANISOU | 5798 | N | PRO | B | 399 | 4010 | 3955 | 3675 | −62 | −1569 | 493 | N |
| ATOM | 5799 | CA | PRO | B | 399 | 9.449 | 31.012 | 41.445 | 1.00 | 28.53 | | C |
| ANISOU | 5799 | CA | PRO | B | 399 | 3714 | 3637 | 3490 | 17 | −1798 | 408 | C |
| ATOM | 5800 | C | PRO | B | 399 | 9.222 | 32.457 | 41.040 | 1.00 | 27.51 | | C |
| ANISOU | 5800 | C | PRO | B | 399 | 3441 | 3588 | 3423 | −11 | −1723 | 326 | C |
| ATOM | 5801 | O | PRO | B | 399 | 8.646 | 32.724 | 39.995 | 1.00 | 28.65 | | O |
| ANISOU | 5801 | O | PRO | B | 399 | 3447 | 3811 | 3627 | −78 | −1514 | 328 | O |
| ATOM | 5802 | CB | PRO | B | 399 | 10.797 | 30.528 | 40.914 | 1.00 | 33.38 | | C |
| ANISOU | 5802 | CB | PRO | B | 399 | 4145 | 4131 | 4409 | 69 | −1940 | 387 | C |
| ATOM | 5803 | CG | PRO | B | 399 | 10.457 | 30.004 | 39.528 | 1.00 | 30.95 | | C |
| ANISOU | 5803 | CG | PRO | B | 399 | 3692 | 3860 | 4208 | 1 | −1691 | 420 | C |
| ATOM | 5804 | CD | PRO | B | 399 | 9.057 | 29.438 | 39.619 | 1.00 | 26.82 | | C |
| ANISOU | 5804 | CD | PRO | B | 399 | 3342 | 3424 | 3424 | −76 | −1513 | 497 | C |
| ATOM | 5805 | N | ASP | B | 400 | 9.691 | 33.387 | 41.854 | 1.00 | 33.29 | | N |
| ANISOU | 5805 | N | ASP | B | 400 | 4223 | 4283 | 4141 | 47 | −1916 | 252 | N |
| ATOM | 5806 | CA | ASP | B | 400 | 9.732 | 34.767 | 41.417 | 1.00 | 30.97 | | C |
| ANISOU | 5806 | CA | ASP | B | 400 | 3770 | 4030 | 3968 | 27 | −1880 | 168 | C |
| ATOM | 5807 | C | ASP | B | 400 | 10.865 | 34.933 | 40.420 | 1.00 | 27.60 | | C |
| ANISOU | 5807 | C | ASP | B | 400 | 3050 | 3525 | 3910 | 22 | −1912 | 131 | C |
| ATOM | 5808 | O | ASP | B | 400 | 11.903 | 34.302 | 40.553 | 1.00 | 28.78 | | O |
| ANISOU | 5808 | O | ASP | B | 400 | 3136 | 3559 | 4239 | 71 | −2083 | 133 | O |
| ATOM | 5809 | CB | ASP | B | 400 | 9.915 | 35.710 | 42.606 | 1.00 | 36.89 | | C |
| ANISOU | 5809 | CB | ASP | B | 400 | 4681 | 4739 | 4597 | 90 | −2093 | 90 | C |
| ATOM | 5810 | CG | ASP | B | 400 | 8.737 | 35.685 | 43.559 | 1.00 | 43.50 | | C |
| ANISOU | 5810 | CG | ASP | B | 400 | 5825 | 5647 | 5056 | 105 | −1994 | 125 | C |
| ATOM | 5811 | OD1 | ASP | B | 400 | 7.593 | 35.501 | 43.087 | 1.00 | 42.71 | | O |
| ANISOU | 5811 | OD1 | ASP | B | 400 | 5713 | 5660 | 4854 | 41 | −1712 | 184 | O |
| ATOM | 5812 | OD2 | ASP | B | 400 | 8.955 | 35.845 | 44.783 | 1.00 | 51.67 | | O |
| ANISOU | 5812 | OD2 | ASP | B | 400 | 7119 | 6609 | 5904 | 185 | −2197 | 94 | O |
| ATOM | 5813 | N | LEU | B | 401 | 10.650 | 35.749 | 39.397 | 1.00 | 29.17 | | N |
| ANISOU | 5813 | N | LEU | B | 401 | 3078 | 3776 | 4231 | −30 | −1730 | 105 | N |
| ATOM | 5814 | CA | LEU | B | 401 | 11.754 | 36.271 | 38.591 | 1.00 | 30.51 | | C |
| ANISOU | 5814 | CA | LEU | B | 401 | 2985 | 3854 | 4753 | −30 | −1738 | 60 | C |
| ATOM | 5815 | C | LEU | B | 401 | 12.196 | 37.618 | 39.203 | 1.00 | 34.11 | | C |
| ANISOU | 5815 | C | LEU | B | 401 | 3414 | 4260 | 5285 | −14 | −1886 | −32 | C |
| ATOM | 5816 | O | LEU | B | 401 | 11.418 | 38.279 | 39.896 | 1.00 | 32.55 | | O |
| ANISOU | 5816 | O | LEU | B | 401 | 3373 | 4130 | 4864 | −12 | −1939 | −63 | O |
| ATOM | 5817 | CB | LEU | B | 401 | 11.331 | 36.449 | 37.128 | 1.00 | 29.19 | | C |
| ANISOU | 5817 | CB | LEU | B | 401 | 2701 | 3741 | 4650 | −89 | −1443 | 88 | C |
| ATOM | 5818 | CG | LEU | B | 401 | 10.799 | 35.190 | 36.420 | 1.00 | 33.36 | | C |
| ANISOU | 5818 | CG | LEU | B | 401 | 3292 | 4305 | 5078 | −110 | −1277 | 166 | C |
| ATOM | 5819 | CD1 | LEU | B | 401 | 10.401 | 35.492 | 34.976 | 1.00 | 34.02 | | C |
| ANISOU | 5819 | CD1 | LEU | B | 401 | 3307 | 4419 | 5201 | −154 | −1027 | 178 | C |
| ATOM | 5820 | CD2 | LEU | B | 401 | 11.798 | 34.058 | 36.445 | 1.00 | 28.25 | | C |
| ANISOU | 5820 | CD2 | LEU | B | 401 | 2593 | 3545 | 4595 | −61 | −1363 | 192 | C |
| ATOM | 5821 | N | PHE | B | 402 | 13.441 | 38.019 | 38.977 | 1.00 | 28.66 | | N |
| ANISOU | 5821 | N | PHE | B | 402 | 2561 | 3437 | 4892 | −2 | −1907 | −75 | N |
| ATOM | 5822 | CA | PHE | B | 402 | 13.910 | 39.288 | 39.528 | 1.00 | 36.12 | | C |
| ANISOU | 5822 | CA | PHE | B | 402 | 3504 | 4307 | 5912 | 4 | −2011 | −158 | C |
| ATOM | 5823 | C | PHE | B | 402 | 14.509 | 40.182 | 38.467 | 1.00 | 39.21 | | C |
| ANISOU | 5823 | C | PHE | B | 402 | 3672 | 4633 | 6594 | −41 | −1845 | −175 | C |
| ATOM | 5824 | O | PHE | B | 402 | 15.523 | 39.859 | 37.842 | 1.00 | 38.32 | | O |
| ANISOU | 5824 | O | PHE | B | 402 | 3384 | 4408 | 6767 | −39 | −1777 | −158 | O |
| ATOM | 5825 | CB | PHE | B | 402 | 14.910 | 39.063 | 40.659 | 1.00 | 36.17 | | C |
| ANISOU | 5825 | CB | PHE | B | 402 | 3583 | 4169 | 5990 | 66 | −2276 | −202 | C |
| ATOM | 5826 | CG | PHE | B | 402 | 14.266 | 38.607 | 41.929 | 1.00 | 37.35 | | C |
| ANISOU | 5826 | CG | PHE | B | 402 | 4030 | 4360 | 5799 | 118 | −2452 | −201 | C |
| ATOM | 5827 | CD2 | PHE | B | 402 | 14.129 | 37.255 | 42.205 | 1.00 | 36.56 | | C |
| ANISOU | 5827 | CD2 | PHE | B | 402 | 4043 | 4275 | 5574 | 152 | −2497 | −134 | C |
| ATOM | 5828 | CD1 | PHE | B | 402 | 13.744 | 39.533 | 42.819 | 1.00 | 37.11 | | C |
| ANISOU | 5828 | CD1 | PHE | B | 402 | 4195 | 4348 | 5558 | 137 | −2552 | −261 | C |
| ATOM | 5829 | CE2 | PHE | B | 402 | 13.508 | 36.834 | 43.362 | 1.00 | 37.43 | | C |
| ANISOU | 5829 | CE2 | PHE | B | 402 | 4464 | 4410 | 5346 | 202 | −2624 | −118 | C |
| ATOM | 5830 | CE1 | PHE | B | 402 | 13.127 | 39.123 | 43.982 | 1.00 | 38.08 | | C |
| ANISOU | 5830 | CE1 | PHE | B | 402 | 4633 | 4497 | 5340 | 195 | −2674 | −254 | C |
| ATOM | 5831 | CZ | PHE | B | 402 | 13.010 | 37.770 | 44.260 | 1.00 | 36.99 | | C |
| ANISOU | 5831 | CZ | PHE | B | 402 | 4616 | 4367 | 5069 | 226 | −2701 | −177 | C |
| ATOM | 5832 | N | VAL | B | 403 | 13.852 | 41.319 | 38.291 | 1.00 | 33.57 | | N |
| ANISOU | 5832 | N | VAL | B | 403 | 2978 | 3977 | 5800 | −76 | −1775 | −206 | N |
| ATOM | 5833 | CA | VAL | B | 403 | 14.240 | 42.325 | 37.322 | 1.00 | 33.76 | | C |
| ANISOU | 5833 | CA | VAL | B | 403 | 2836 | 3938 | 6052 | −121 | −1610 | −216 | C |
| ATOM | 5834 | C | VAL | B | 403 | 15.089 | 43.400 | 37.968 | 1.00 | 37.32 | | C |
| ANISOU | 5834 | C | VAL | B | 403 | 3258 | 4245 | 6677 | −114 | −1771 | −292 | C |
| ATOM | 5835 | O | VAL | B | 403 | 14.616 | 44.089 | 38.873 | 1.00 | 40.62 | | O |
| ANISOU | 5835 | O | VAL | B | 403 | 3824 | 4686 | 6925 | −98 | −1926 | −352 | O |
| ATOM | 5836 | CB | VAL | B | 403 | 13.004 | 42.983 | 36.731 | 1.00 | 32.18 | | C |
| ANISOU | 5836 | CB | VAL | B | 403 | 2681 | 3868 | 5679 | −159 | −1458 | −206 | C |
| ATOM | 5837 | CG1 | VAL | B | 403 | 13.398 | 43.968 | 35.668 | 1.00 | 35.25 | | C |
| ANISOU | 5837 | CG1 | VAL | B | 403 | 2924 | 4176 | 6293 | −202 | −1276 | −203 | C |
| ATOM | 5838 | CG2 | VAL | B | 403 | 12.055 | 41.912 | 36.186 | 1.00 | 36.15 | | C |
| ANISOU | 5838 | CG2 | VAL | B | 403 | 3228 | 4504 | 6006 | −168 | −1338 | −135 | C |
| ATOM | 5839 | N | THR | B | 404 | 16.332 | 43.549 | 37.516 | 1.00 | 37.49 | | N |
| ANISOU | 5839 | N | THR | B | 404 | 3095 | 4105 | 7045 | −123 | −1735 | −290 | N |
| ATOM | 5840 | CA | THR | B | 404 | 17.180 | 44.640 | 38.004 | 1.00 | 41.05 | | C |
| ANISOU | 5840 | CA | THR | B | 404 | 3486 | 4392 | 7718 | −127 | −1882 | −358 | C |
| ATOM | 5841 | C | THR | B | 404 | 17.046 | 45.838 | 37.081 | 1.00 | 40.32 | | C |
| ANISOU | 5841 | C | THR | B | 404 | 3296 | 4275 | 7747 | −183 | −1686 | −353 | C |
| ATOM | 5842 | O | THR | B | 404 | 17.301 | 45.754 | 35.884 | 1.00 | 46.54 | | O |
| ANISOU | 5842 | O | THR | B | 404 | 3948 | 5036 | 8698 | −214 | −1429 | −292 | O |
| ATOM | 5843 | CB | THR | B | 404 | 18.665 | 44.236 | 38.109 | 1.00 | 44.59 | | C |
| ANISOU | 5843 | CB | THR | B | 404 | 3771 | 4645 | 8525 | −104 | −1975 | −363 | C |
| ATOM | 5844 | OG1 | THR | B | 404 | 18.800 | 43.180 | 39.067 | 1.00 | 46.31 | | O |
| ANISOU | 5844 | OG1 | THR | B | 404 | 4103 | 4866 | 8628 | −46 | −2195 | −374 | O |
| ATOM | 5845 | CG2 | THR | B | 404 | 19.513 | 45.424 | 38.560 | 1.00 | 39.54 | | C |
| ANISOU | 5845 | CG2 | THR | B | 404 | 3055 | 3821 | 8149 | −114 | −2134 | −432 | C |
| ATOM | 5846 | N | LEU | B | 405 | 16.633 | 46.955 | 37.652 | 1.00 | 40.64 | | N |
| ANISOU | 5846 | N | LEU | B | 405 | 3429 | 4313 | 7700 | −191 | −1805 | −418 | N |
| ATOM | 5847 | CA | LEU | B | 405 | 16.401 | 48.160 | 36.879 | 1.00 | 40.55 | | C |
| ANISOU | 5847 | CA | LEU | B | 405 | 3352 | 4273 | 7782 | −242 | −1647 | −418 | C |
| ATOM | 5848 | C | LEU | B | 405 | 17.639 | 49.047 | 36.797 | 1.00 | 49.32 | | C |
| ANISOU | 5848 | C | LEU | B | 405 | 4298 | 5162 | 9279 | −264 | −1687 | −444 | C |
| ATOM | 5849 | O | LEU | B | 405 | 18.738 | 48.651 | 37.208 | 1.00 | 45.10 | | O |
| ANISOU | 5849 | O | LEU | B | 405 | 3669 | 4491 | 8976 | −239 | −1819 | −457 | O |
| ATOM | 5850 | CB | LEU | B | 405 | 15.238 | 48.926 | 37.480 | 1.00 | 33.39 | | C |
| ANISOU | 5850 | CB | LEU | B | 405 | 2626 | 3472 | 6589 | −236 | −1745 | −477 | C |
| ATOM | 5851 | CG | LEU | B | 405 | 13.991 | 48.049 | 37.487 | 1.00 | 40.04 | | C |
| ANISOU | 5851 | CG | LEU | B | 405 | 3605 | 4523 | 7084 | −215 | −1682 | −443 | C |
| ATOM | 5852 | CD1 | LEU | B | 405 | 12.816 | 48.723 | 38.158 | 1.00 | 38.56 | | C |
| ANISOU | 5852 | CD1 | LEU | B | 405 | 3601 | 4436 | 6615 | −191 | −1776 | −506 | C |
| ATOM | 5853 | CD2 | LEU | B | 405 | 13.629 | 47.669 | 36.058 | 1.00 | 44.03 | | C |
| ANISOU | 5853 | CD2 | LEU | B | 405 | 4007 | 5097 | 7624 | −254 | −1387 | −354 | C |
| ATOM | 5854 | N | SER | B | 406 | 17.437 | 50.253 | 36.277 | 1.00 | 52.73 | | N |
| ANISOU | 5854 | N | SER | B | 406 | 4693 | 5549 | 9794 | −308 | −1582 | −451 | N |
| ATOM | 5855 | CA | SER | B | 406 | 18.525 | 51.165 | 35.955 | 1.00 | 59.99 | | C |
| ANISOU | 5855 | CA | SER | B | 406 | 5436 | 6254 | 11102 | −340 | −1554 | −456 | C |
| ATOM | 5856 | C | SER | B | 406 | 19.365 | 51.512 | 37.175 | 1.00 | 61.77 | | C |
| ANISOU | 5856 | C | SER | B | 406 | 5654 | 6328 | 11488 | −307 | −1892 | −542 | C |
| ATOM | 5857 | O | SER | B | 406 | 20.595 | 51.471 | 37.124 | 1.00 | 68.17 | | O |
| ANISOU | 5857 | O | SER | B | 406 | 6284 | 6956 | 12659 | −306 | −1927 | −536 | O |
| ATOM | 5858 | CB | SER | B | 406 | 17.967 | 52.436 | 35.320 | 1.00 | 67.90 | | C |
| ANISOU | 5858 | CB | SER | B | 406 | 6446 | 7244 | 12110 | −391 | −1411 | −453 | C |
| ATOM | 5859 | OG | SER | B | 406 | 18.915 | 53.010 | 34.438 | 1.00 | 78.83 | | O |
| ANISOU | 5859 | OG | SER | B | 406 | 7639 | 8449 | 13864 | −431 | −1215 | −403 | O |
| ATOM | 5860 | N | ASN | B | 407 | 18.697 | 51.868 | 38.266 | 1.00 | 63.51 | | N |
| ANISOU | 5860 | N | ASN | B | 407 | 6078 | 6607 | 11446 | −275 | −2140 | −624 | N |
| ATOM | 5861 | CA | ASN | B | 407 | 19.384 | 52.235 | 39.499 | 1.00 | 67.79 | | C |
| ANISOU | 5861 | CA | ASN | B | 407 | 6670 | 6998 | 12090 | −231 | −2489 | −714 | C |
| ATOM | 5862 | C | ASN | B | 407 | 19.740 | 51.000 | 40.326 | 1.00 | 67.46 | | C |
| ANISOU | 5862 | C | ASN | B | 407 | 6703 | 6963 | 11964 | −168 | −2680 | −722 | C |
| ATOM | 5863 | O | ASN | B | 407 | 19.977 | 51.083 | 41.534 | 1.00 | 66.03 | | O |
| ANISOU | 5863 | O | ASN | B | 407 | 6667 | 6699 | 11724 | −111 | −2997 | −799 | O |
| ATOM | 5864 | CB | ASN | B | 407 | 18.516 | 53.196 | 40.308 | 1.00 | 68.06 | | C |
| ANISOU | 5864 | CB | ASN | B | 407 | 6928 | 7069 | 11862 | −211 | −2661 | −803 | C |
| ATOM | 5865 | CG | ASN | B | 407 | 17.229 | 52.551 | 40.778 | 1.00 | 78.22 | | C |
| ANISOU | 5865 | CG | ASN | B | 407 | 8464 | 8574 | 12683 | −168 | −2661 | −811 | C |
| ATOM | 5866 | OD1 | ASN | B | 407 | 16.875 | 51.454 | 40.341 | 1.00 | 78.26 | | O |
| ANISOU | 5866 | OD1 | ASN | B | 407 | 8456 | 8718 | 12559 | −168 | −2505 | −740 | O |
| ATOM | 5867 | ND2 | ASN | B | 407 | 16.515 | 53.231 | 41.664 | 1.00 | 84.16 | | N |
| ANISOU | 5867 | ND2 | ASN | B | 407 | 9447 | 9346 | 13182 | −125 | −2828 | −898 | N |
| ATOM | 5868 | N | ASN | B | 408 | 19.755 | 49.855 | 39.655 | 1.00 | 69.81 | | N |
| ANISOU | 5868 | N | ASN | B | 408 | 6924 | 7351 | 12251 | −173 | −2487 | −642 | N |
| ATOM | 5869 | CA | ASN | B | 408 | 20.177 | 48.599 | 40.254 | 1.00 | 70.58 | | C |
| ANISOU | 5869 | CA | ASN | B | 408 | 7059 | 7441 | 12315 | −119 | −2634 | −635 | C |
| ATOM | 5870 | C | ASN | B | 408 | 19.286 | 48.208 | 41.420 | 1.00 | 65.70 | | C |
| ANISOU | 5870 | C | ASN | B | 408 | 6743 | 6943 | 11276 | −60 | −2838 | −680 | C |
| ATOM | 5871 | O | ASN | B | 408 | 19.745 | 47.673 | 42.424 | 1.00 | 68.81 | | O |
| ANISOU | 5871 | O | ASN | B | 408 | 7243 | 7255 | 11647 | 1 | −3101 | −717 | O |
| ATOM | 5872 | CB | ASN | B | 408 | 21.640 | 48.687 | 40.675 | 1.00 | 75.10 | | C |
| ANISOU | 5872 | CB | ASN | B | 408 | 7474 | 7760 | 13301 | −99 | −2848 | −673 | C |
| ATOM | 5873 | CG | ASN | B | 408 | 22.542 | 49.054 | 39.515 | 1.00 | 79.39 | | C |
| ANISOU | 5873 | CG | ASN | B | 408 | 7715 | 8169 | 14281 | −152 | −2613 | −621 | C |
| ATOM | 5874 | OD1 | ASN | B | 408 | 22.628 | 48.320 | 38.527 | 1.00 | 80.36 | | O |
| ANISOU | 5874 | OD1 | ASN | B | 408 | 7720 | 8345 | 14468 | −171 | −2338 | −541 | O |
| ATOM | 5875 | ND2 | ASN | B | 408 | 23.205 | 50.203 | 39.616 | 1.00 | 81.60 | | N |
| ANISOU | 5875 | ND2 | ASN | B | 408 | 7879 | 8265 | 14862 | −173 | −2708 | −665 | N |
| ATOM | 5876 | N | TYR | B | 409 | 17.999 | 48.494 | 41.276 | 1.00 | 62.80 | | N |
| ANISOU | 5876 | N | TYR | B | 409 | 6523 | 6758 | 10580 | −73 | −2711 | −675 | N |
| ATOM | 5877 | CA | TYR | B | 409 | 17.003 | 47.947 | 42.180 | 1.00 | 58.41 | | C |
| ANISOU | 5877 | CA | TYR | B | 409 | 6247 | 6343 | 9604 | −17 | −2814 | −693 | C |
| ATOM | 5878 | C | TYR | B | 409 | 16.502 | 46.606 | 41.631 | 1.00 | 57.14 | | C |
| ANISOU | 5878 | C | TYR | B | 409 | 6072 | 6344 | 9294 | −21 | −2630 | −602 | C |
| ATOM | 5879 | O | TYR | B | 409 | 16.064 | 46.510 | 40.483 | 1.00 | 54.34 | | O |
| ANISOU | 5879 | O | TYR | B | 409 | 5593 | 6092 | 8963 | −73 | −2360 | −538 | O |
| ATOM | 5880 | CB | TYR | B | 409 | 15.828 | 48.906 | 42.377 | 1.00 | 52.95 | | C |
| ANISOU | 5880 | CB | TYR | B | 409 | 5724 | 5753 | 8641 | −17 | −2781 | −740 | C |
| ATOM | 5881 | CG | TYR | B | 409 | 14.788 | 48.351 | 43.323 | 1.00 | 53.74 | | C |
| ANISOU | 5881 | CG | TYR | B | 409 | 6124 | 5986 | 8308 | 49 | −2858 | −755 | C |
| ATOM | 5882 | CD2 | TYR | B | 409 | 14.801 | 48.691 | 44.669 | 1.00 | 63.07 | | C |
| ANISOU | 5882 | CD2 | TYR | B | 409 | 7572 | 7080 | 9312 | 128 | −3119 | −838 | C |
| ATOM | 5883 | CD1 | TYR | B | 409 | 13.808 | 47.469 | 42.879 | 1.00 | 48.21 | | C |
| ANISOU | 5883 | CD1 | TYR | B | 409 | 5457 | 5481 | 7378 | 41 | −2665 | −682 | C |
| ATOM | 5884 | CE2 | TYR | B | 409 | 13.863 | 48.175 | 45.546 | 1.00 | 63.92 | | C |
| ANISOU | 5884 | CE2 | TYR | B | 409 | 7986 | 7291 | 9008 | 198 | −3155 | −844 | C |
| ATOM | 5885 | CE1 | TYR | B | 409 | 12.872 | 46.948 | 43.747 | 1.00 | 51.83 | | C |
| ANISOU | 5885 | CE1 | TYR | B | 409 | 6193 | 6046 | 7455 | 103 | −2716 | −687 | C |
| ATOM | 5886 | CZ | TYR | B | 409 | 12.902 | 47.303 | 45.078 | 1.00 | 60.59 | | C |
| ANISOU | 5886 | CZ | TYR | B | 409 | 7579 | 7066 | 8376 | 183 | −2944 | −765 | C |
| ATOM | 5887 | OH | TYR | B | 409 | 11.965 | 46.786 | 45.942 | 1.00 | 66.30 | | O |
| ANISOU | 5887 | OH | TYR | B | 409 | 8613 | 7881 | 8697 | 254 | −2953 | −760 | O |
| ATOM | 5888 | N | LYS | B | 410 | 16.566 | 45.586 | 42.479 | 1.00 | 55.05 | | N |
| ANISOU | 5888 | N | LYS | B | 410 | 5957 | 6085 | 8875 | 38 | −2789 | −597 | N |
| ATOM | 5889 | CA | LYS | B | 410 | 16.146 | 44.235 | 42.151 | 1.00 | 49.16 | | C |
| ANISOU | 5889 | CA | LYS | B | 410 | 5225 | 5467 | 7986 | 44 | −2667 | −515 | C |
| ATOM | 5890 | C | LYS | B | 410 | 14.633 | 44.061 | 42.405 | 1.00 | 46.44 | | C |
| ANISOU | 5890 | C | LYS | B | 410 | 5099 | 5321 | 7226 | 56 | −2585 | −496 | C |
| ATOM | 5891 | O | LYS | B | 410 | 14.191 | 43.922 | 43.555 | 1.00 | 42.59 | | O |
| ANISOU | 5891 | O | LYS | B | 410 | 4879 | 4845 | 6459 | 117 | −2748 | −528 | O |
| ATOM | 5892 | CB | LYS | B | 410 | 16.968 | 43.246 | 42.979 | 1.00 | 51.91 | | C |
| ANISOU | 5892 | CB | LYS | B | 410 | 5640 | 5703 | 8383 | 106 | −2893 | −518 | C |
| ATOM | 5893 | CG | LYS | B | 410 | 17.428 | 41.993 | 42.251 | 1.00 | 57.20 | | C |
| ANISOU | 5893 | CG | LYS | B | 410 | 6149 | 6380 | 9203 | 99 | −2776 | −440 | C |
| ATOM | 5894 | CD | LYS | B | 410 | 17.767 | 40.906 | 43.270 | 1.00 | 60.55 | | C |
| ANISOU | 5894 | CD | LYS | B | 410 | 6739 | 6741 | 9526 | 173 | −3011 | −438 | C |
| ATOM | 5895 | CE | LYS | B | 410 | 18.691 | 39.863 | 42.701 | 1.00 | 66.82 | | C |
| ANISOU | 5895 | CE | LYS | B | 410 | 7337 | 7453 | 10597 | 179 | −2978 | −392 | C |
| ATOM | 5896 | NZ | LYS | B | 410 | 18.537 | 38.581 | 43.454 | 1.00 | 68.21 | | N |
| ANISOU | 5896 | NZ | LYS | B | 410 | 7710 | 7641 | 10567 | 244 | −3122 | −358 | N |
| ATOM | 5897 | N | MET | B | 411 | 13.841 | 44.086 | 41.333 | 1.00 | 37.33 | | N |
| ANISOU | 5897 | N | MET | B | 411 | 3845 | 4306 | 6034 | 2 | −2330 | −444 | N |
| ATOM | 5898 | CA | MET | B | 411 | 12.392 | 44.048 | 41.477 | 1.00 | 33.48 | | C |
| ANISOU | 5898 | CA | MET | B | 411 | 3526 | 3990 | 5204 | 9 | −2249 | −431 | C |
| ATOM | 5899 | C | MET | B | 411 | 11.794 | 42.653 | 41.298 | 1.00 | 37.90 | | C |
| ANISOU | 5899 | C | MET | B | 411 | 4135 | 4667 | 5596 | 13 | −2164 | −343 | C |
| ATOM | 5900 | O | MET | B | 411 | 12.173 | 41.920 | 40.393 | 1.00 | 42.52 | | O |
| ANISOU | 5900 | O | MET | B | 411 | 4551 | 5253 | 6352 | −19 | −2042 | −280 | O |
| ATOM | 5901 | CB | MET | B | 411 | 11.755 | 45.012 | 40.496 | 1.00 | 29.90 | | C |
| ANISOU | 5901 | CB | MET | B | 411 | 2956 | 3604 | 4800 | −45 | −2058 | −436 | C |
| ATOM | 5902 | CG | MET | B | 411 | 10.261 | 44.899 | 40.461 | 1.00 | 36.39 | | C |
| ANISOU | 5902 | CG | MET | B | 411 | 3902 | 4599 | 5327 | −38 | −1960 | −418 | C |
| ATOM | 5903 | SD | MET | B | 411 | 9.574 | 46.167 | 39.394 | 1.00 | 53.96 | | S |
| ANISOU | 5903 | SD | MET | B | 411 | 6016 | 6868 | 7618 | −82 | −1748 | −431 | S |
| ATOM | 5904 | CE | MET | B | 411 | 10.144 | 47.592 | 40.285 | 1.00 | 70.33 | | C |
| ANISOU | 5904 | CE | MET | B | 411 | 8158 | 8797 | 9766 | −54 | −1976 | −558 | C |
| ATOM | 5905 | N | LYS | B | 412 | 10.854 | 42.298 | 42.169 | 1.00 | 35.19 | | N |
| ANISOU | 5905 | N | LYS | B | 412 | 4047 | 4410 | 4914 | 57 | −2223 | −338 | N |
| ATOM | 5906 | CA | LYS | B | 412 | 10.249 | 40.969 | 42.157 | 1.00 | 32.39 | | C |
| ANISOU | 5906 | CA | LYS | B | 412 | 3780 | 4147 | 4382 | 61 | −2167 | −248 | C |
| ATOM | 5907 | C | LYS | B | 412 | 9.140 | 40.883 | 41.117 | 1.00 | 34.34 | | C |
| ANISOU | 5907 | C | LYS | B | 412 | 3949 | 4537 | 4562 | 0 | −1839 | −181 | C |
| ATOM | 5908 | O | LYS | B | 412 | 8.202 | 41.677 | 41.121 | 1.00 | 34.69 | | O |
| ANISOU | 5908 | O | LYS | B | 412 | 4056 | 4659 | 4467 | −3 | −1705 | −203 | O |
| ATOM | 5909 | CB | LYS | B | 412 | 9.719 | 40.633 | 43.553 | 1.00 | 40.10 | | C |
| ANISOU | 5909 | CB | LYS | B | 412 | 5109 | 5129 | 4998 | 136 | −2291 | −251 | C |
| ATOM | 5910 | CG | LYS | B | 412 | 8.928 | 39.348 | 43.668 | 1.00 | 42.08 | | C |
| ANISOU | 5910 | CG | LYS | B | 412 | 5502 | 5464 | 5021 | 131 | −2123 | −137 | C |
| ATOM | 5911 | CD | LYS | B | 412 | 8.398 | 39.126 | 45.092 | 1.00 | 38.09 | | C |
| ANISOU | 5911 | CD | LYS | B | 412 | 5387 | 4944 | 4142 | 210 | −2191 | −131 | C |
| ATOM | 5912 | CE | LYS | B | 412 | 9.513 | 38.854 | 46.070 | 1.00 | 41.45 | | C |
| ANISOU | 5912 | CE | LYS | B | 412 | 5960 | 5209 | 4581 | 286 | −2503 | −171 | C |
| ATOM | 5913 | NZ | LYS | B | 412 | 9.048 | 38.807 | 47.494 | 1.00 | 45.31 | | N |
| ANISOU | 5913 | NZ | LYS | B | 412 | 6872 | 5654 | 4691 | 375 | −2546 | −175 | N |
| ATOM | 5914 | N | TRP | B | 413 | 9.264 | 39.932 | 40.202 | 1.00 | 37.07 | | N |
| ANISOU | 5914 | N | TRP | B | 413 | 4162 | 4902 | 5021 | −41 | −1710 | −105 | N |
| ATOM | 5915 | CA | TRP | B | 413 | 8.239 | 39.713 | 39.190 | 1.00 | 31.88 | | C |
| ANISOU | 5915 | CA | TRP | B | 413 | 3456 | 4357 | 4300 | −97 | −1432 | −42 | C |
| ATOM | 5916 | C | TRP | B | 413 | 7.580 | 38.367 | 39.494 | 1.00 | 36.54 | | C |
| ANISOU | 5916 | C | TRP | B | 413 | 4184 | 5002 | 4699 | −103 | −1364 | 44 | C |
| ATOM | 5917 | O | TRP | B | 413 | 8.166 | 37.299 | 39.248 | 1.00 | 34.80 | | O |
| ANISOU | 5917 | O | TRP | B | 413 | 3928 | 4730 | 4566 | −106 | −1401 | 91 | O |
| ATOM | 5918 | CB | TRP | B | 413 | 8.847 | 39.737 | 37.786 | 1.00 | 32.96 | | C |
| ANISOU | 5918 | CB | TRP | B | 413 | 3370 | 4451 | 4702 | −138 | −1320 | −26 | C |
| ATOM | 5919 | CG | TRP | B | 413 | 7.854 | 39.796 | 36.648 | 1.00 | 26.92 | | C |
| ANISOU | 5919 | CG | TRP | B | 413 | 2577 | 3774 | 3878 | −184 | −1081 | 16 | C |
| ATOM | 5920 | CD1 | TRP | B | 413 | 6.531 | 40.090 | 36.727 | 1.00 | 28.49 | | C |
| ANISOU | 5920 | CD1 | TRP | B | 413 | 2863 | 4080 | 3882 | −196 | −977 | 26 | C |
| ATOM | 5921 | CD2 | TRP | B | 413 | 8.123 | 39.520 | 35.263 | 1.00 | 25.53 | | C |
| ANISOU | 5921 | CD2 | TRP | B | 413 | 2291 | 3565 | 3845 | −214 | −932 | 52 | C |
| ATOM | 5922 | NE1 | TRP | B | 413 | 5.959 | 40.041 | 35.477 | 1.00 | 28.48 | | N |
| ANISOU | 5922 | NE1 | TRP | B | 413 | 2803 | 4112 | 3905 | −234 | −816 | 61 | N |
| ATOM | 5923 | CE2 | TRP | B | 413 | 6.915 | 39.692 | 34.563 | 1.00 | 27.87 | | C |
| ANISOU | 5923 | CE2 | TRP | B | 413 | 2634 | 3949 | 4007 | −242 | −784 | 77 | C |
| ATOM | 5924 | CE3 | TRP | B | 413 | 9.276 | 39.174 | 34.549 | 1.00 | 29.00 | | C |
| ANISOU | 5924 | CE3 | TRP | B | 413 | 2605 | 3895 | 4520 | −209 | −903 | 63 | C |
| ATOM | 5925 | CZ2 | TRP | B | 413 | 6.822 | 39.515 | 33.177 | 1.00 | 30.25 | | C |
| ANISOU | 5925 | CZ2 | TRP | B | 413 | 2906 | 4227 | 4361 | −264 | −638 | 110 | C |
| ATOM | 5926 | CZ3 | TRP | B | 413 | 9.182 | 38.997 | 33.173 | 1.00 | 28.28 | | C |
| ANISOU | 5926 | CZ3 | TRP | B | 413 | 2487 | 3785 | 4473 | −228 | −706 | 101 | C |
| ATOM | 5927 | CH2 | TRP | B | 413 | 7.959 | 39.161 | 32.502 | 1.00 | 22.73 | | C |
| ANISOU | 5927 | CH2 | TRP | B | 413 | 1879 | 3167 | 3592 | −254 | −590 | 122 | C |
| ATOM | 5928 | N | GLN | B | 414 | 6.365 | 38.430 | 40.033 | 1.00 | 32.18 | | N |
| ANISOU | 5928 | N | GLN | B | 414 | 3780 | 4539 | 3905 | −104 | −1253 | 66 | N |
| ATOM | 5929 | CA | GLN | B | 414 | 5.672 | 37.260 | 40.561 | 1.00 | 31.15 | | C |
| ANISOU | 5929 | CA | GLN | B | 414 | 3806 | 4444 | 3586 | −114 | −1179 | 150 | C |
| ATOM | 5930 | C | GLN | B | 414 | 4.931 | 36.445 | 39.511 | 1.00 | 26.09 | | C |
| ANISOU | 5930 | C | GLN | B | 414 | 3065 | 3860 | 2989 | −191 | −991 | 225 | C |
| ATOM | 5931 | O | GLN | B | 414 | 4.549 | 36.968 | 38.490 | 1.00 | 30.49 | | O |
| ANISOU | 5931 | O | GLN | B | 414 | 3480 | 4460 | 3645 | −228 | −886 | 209 | O |
| ATOM | 5932 | CB | GLN | B | 414 | 4.692 | 37.706 | 41.643 | 1.00 | 31.58 | | C |
| ANISOU | 5932 | CB | GLN | B | 414 | 4062 | 4548 | 3387 | −79 | −1105 | 146 | C |
| ATOM | 5933 | CG | GLN | B | 414 | 5.366 | 38.307 | 42.864 | 1.00 | 32.96 | | C |
| ANISOU | 5933 | CG | GLN | B | 414 | 4432 | 4644 | 3448 | 11 | −1320 | 73 | C |
| ATOM | 5934 | CD | GLN | B | 414 | 4.360 | 38.717 | 43.908 | 1.00 | 39.92 | | C |
| ANISOU | 5934 | CD | GLN | B | 414 | 5556 | 5563 | 4048 | 61 | −1200 | 70 | C |
| ATOM | 5935 | OE1 | GLN | B | 414 | 3.691 | 37.874 | 44.507 | 1.00 | 49.73 | | O |
| ANISOU | 5935 | OE1 | GLN | B | 414 | 6975 | 6820 | 5100 | 62 | −1070 | 154 | O |
| ATOM | 5936 | NE2 | GLN | B | 414 | 4.199 | 40.022 | 44.088 | 1.00 | 38.82 | | N |
| ANISOU | 5936 | NE2 | GLN | B | 414 | 5426 | 5431 | 3892 | 102 | −1209 | −22 | N |
| ATOM | 5937 | N | PRO | B | 415 | 4.734 | 35.139 | 39.766 | 1.00 | 29.29 | | N |
| ANISOU | 5937 | N | PRO | B | 415 | 3565 | 4248 | 3316 | −213 | −967 | 307 | N |
| ATOM | 5938 | CA | PRO | B | 415 | 3.978 | 34.286 | 38.842 | 1.00 | 23.79 | | C |
| ANISOU | 5938 | CA | PRO | B | 415 | 2795 | 3584 | 2659 | −292 | −817 | 372 | C |
| ATOM | 5939 | C | PRO | B | 415 | 2.526 | 34.758 | 38.587 | 1.00 | 25.95 | | C |
| ANISOU | 5939 | C | PRO | B | 415 | 3022 | 3954 | 2884 | −342 | −637 | 383 | C |
| ATOM | 5940 | O | PRO | B | 415 | 2.015 | 34.550 | 37.483 | 1.00 | 21.56 | | O |
| ANISOU | 5940 | O | PRO | B | 415 | 2348 | 3418 | 2425 | −399 | −564 | 397 | O |
| ATOM | 5941 | CB | PRO | B | 415 | 3.994 | 32.927 | 39.542 | 1.00 | 23.84 | | C |
| ANISOU | 5941 | CB | PRO | B | 415 | 2960 | 3538 | 2561 | −299 | −839 | 456 | C |
| ATOM | 5942 | CG | PRO | B | 415 | 5.187 | 32.960 | 40.414 | 1.00 | 24.93 | | C |
| ANISOU | 5942 | CG | PRO | B | 415 | 3203 | 3591 | 2677 | −213 | −1051 | 426 | C |
| ATOM | 5943 | CD | PRO | B | 415 | 5.284 | 34.367 | 40.894 | 1.00 | 25.93 | | C |
| ANISOU | 5943 | CD | PRO | B | 415 | 3335 | 3746 | 2771 | −163 | −1108 | 340 | C |
| ATOM | 5944 | N | HIS | B | 416 | 1.876 | 35.397 | 39.558 | 1.00 | 23.27 | | N |
| ANISOU | 5944 | N | HIS | B | 416 | 2775 | 3659 | 2406 | −310 | −574 | 373 | N |
| ATOM | 5945 | CA | HIS | B | 416 | 0.526 | 35.886 | 39.303 | 1.00 | 26.93 | | C |
| ANISOU | 5945 | CA | HIS | B | 416 | 3154 | 4203 | 2875 | −344 | −400 | 380 | C |
| ATOM | 5946 | C | HIS | B | 416 | 0.552 | 37.083 | 38.358 | 1.00 | 33.06 | | C |
| ANISOU | 5946 | C | HIS | B | 416 | 3775 | 5011 | 3775 | −330 | −422 | 302 | C |
| ATOM | 5947 | O | HIS | B | 416 | −0.500 | 37.596 | 37.963 | 1.00 | 39.31 | | O |
| ANISOU | 5947 | O | HIS | B | 416 | 4470 | 5859 | 4609 | −348 | −316 | 297 | O |
| ATOM | 5948 | CB | HIS | B | 416 | −0.233 | 36.262 | 40.588 | 1.00 | 28.92 | | C |
| ANISOU | 5948 | CB | HIS | B | 416 | 3552 | 4484 | 2952 | −300 | −276 | 391 | C |
| ATOM | 5949 | CG | HIS | B | 416 | 0.318 | 37.447 | 41.322 | 1.00 | 30.67 | | C |
| ANISOU | 5949 | CG | HIS | B | 416 | 3881 | 4694 | 3076 | −203 | −367 | 302 | C |
| ATOM | 5950 | ND1 | HIS | B | 416 | 0.312 | 37.525 | 42.697 | 1.00 | 35.26 | | N |
| ANISOU | 5950 | ND1 | HIS | B | 416 | 4717 | 5244 | 3435 | −130 | −352 | 304 | N |
| ATOM | 5951 | CD2 | HIS | B | 416 | 0.902 | 38.587 | 40.885 | 1.00 | 31.02 | | C |
| ANISOU | 5951 | CD2 | HIS | B | 416 | 3840 | 4737 | 3212 | −166 | −480 | 208 | C |
| ATOM | 5952 | CE1 | HIS | B | 416 | 0.858 | 38.667 | 43.074 | 1.00 | 34.22 | | C |
| ANISOU | 5952 | CE1 | HIS | B | 416 | 4649 | 5090 | 3261 | −52 | −476 | 203 | C |
| ATOM | 5953 | NE2 | HIS | B | 416 | 1.215 | 39.334 | 41.994 | 1.00 | 29.90 | | N |
| ANISOU | 5953 | NE2 | HIS | B | 416 | 3882 | 4561 | 2919 | −78 | −550 | 147 | N |
| ATOM | 5954 | N | SER | B | 417 | 1.753 | 37.542 | 38.018 | 1.00 | 30.15 | | N |
| ANISOU | 5954 | N | SER | B | 417 | 3381 | 4592 | 3482 | −296 | −559 | 247 | N |
| ATOM | 5955 | CA | SER | B | 417 | 1.900 | 38.549 | 36.974 | 1.00 | 27.82 | | C |
| ANISOU | 5955 | CA | SER | B | 417 | 2956 | 4300 | 3315 | −292 | −565 | 191 | C |
| ATOM | 5956 | C | SER | B | 417 | 2.327 | 37.917 | 35.657 | 1.00 | 24.79 | | C |
| ANISOU | 5956 | C | SER | B | 417 | 2493 | 3871 | 3054 | −334 | −569 | 216 | C |
| ATOM | 5957 | O | SER | B | 417 | 1.625 | 38.042 | 34.660 | 1.00 | 20.48 | | O |
| ANISOU | 5957 | O | SER | B | 417 | 1886 | 3346 | 2551 | −363 | −508 | 223 | O |
| ATOM | 5958 | CB | SER | B | 417 | 2.911 | 39.630 | 37.384 | 1.00 | 26.87 | | C |
| ANISOU | 5958 | CB | SER | B | 417 | 2848 | 4131 | 3231 | −232 | −681 | 113 | C |
| ATOM | 5959 | OG | SER | B | 417 | 2.447 | 40.365 | 38.501 | 1.00 | 28.14 | | O |
| ANISOU | 5959 | OG | SER | B | 417 | 3114 | 4321 | 3257 | −180 | −677 | 73 | O |
| ATOM | 5960 | N | TYR | B | 418 | 3.470 | 37.234 | 35.641 | 1.00 | 25.87 | | N |
| ANISOU | 5960 | N | TYR | B | 418 | 2646 | 3933 | 3249 | −326 | −647 | 226 | N |
| ATOM | 5961 | CA | TYR | B | 418 | 3.993 | 36.745 | 34.368 | 1.00 | 23.03 | | C |
| ANISOU | 5961 | CA | TYR | B | 418 | 2232 | 3514 | 3006 | −345 | −621 | 240 | C |
| ATOM | 5962 | C | TYR | B | 418 | 3.258 | 35.496 | 33.860 | 1.00 | 29.62 | | C |
| ANISOU | 5962 | C | TYR | B | 418 | 3107 | 4351 | 3796 | −400 | −571 | 300 | C |
| ATOM | 5963 | O | TYR | B | 418 | 3.423 | 35.126 | 32.700 | 1.00 | 32.80 | | O |
| ANISOU | 5963 | O | TYR | B | 418 | 3505 | 4703 | 4256 | −412 | −539 | 306 | O |
| ATOM | 5964 | CB | TYR | B | 418 | 5.502 | 36.495 | 34.446 | 1.00 | 23.41 | | C |
| ANISOU | 5964 | CB | TYR | B | 418 | 2248 | 3463 | 3181 | −307 | −700 | 226 | C |
| ATOM | 5965 | CG | TYR | B | 418 | 6.013 | 35.347 | 35.323 | 1.00 | 29.71 | | C |
| ANISOU | 5965 | CG | TYR | B | 418 | 3117 | 4221 | 3951 | −292 | −797 | 262 | C |
| ATOM | 5966 | CD1 | TYR | B | 418 | 5.907 | 34.019 | 34.918 | 1.00 | 21.49 | | C |
| ANISOU | 5966 | CD1 | TYR | B | 418 | 2121 | 3148 | 2896 | −318 | −763 | 319 | C |
| ATOM | 5967 | CD2 | TYR | B | 418 | 6.674 | 35.610 | 36.521 | 1.00 | 23.98 | | C |
| ANISOU | 5967 | CD2 | TYR | B | 418 | 2431 | 3466 | 3217 | −243 | −947 | 234 | C |
| ATOM | 5968 | CE1 | TYR | B | 418 | 6.401 | 33.000 | 35.706 | 1.00 | 30.19 | | C |
| ANISOU | 5968 | CE1 | TYR | B | 418 | 3299 | 4196 | 3975 | −296 | −858 | 356 | C |
| ATOM | 5969 | CE2 | TYR | B | 418 | 7.174 | 34.602 | 37.304 | 1.00 | 24.74 | | C |
| ANISOU | 5969 | CE2 | TYR | B | 418 | 2616 | 3506 | 3279 | −215 | −1063 | 269 | C |
| ATOM | 5970 | CZ | TYR | B | 418 | 7.037 | 33.301 | 36.900 | 1.00 | 37.18 | | C |
| ANISOU | 5970 | CZ | TYR | B | 418 | 4228 | 5055 | 4842 | −241 | −1010 | 334 | C |
| ATOM | 5971 | OH | TYR | B | 418 | 7.540 | 32.302 | 37.707 | 1.00 | 41.60 | | O |
| ANISOU | 5971 | OH | TYR | B | 418 | 4893 | 5546 | 5365 | −205 | −1134 | 374 | O |
| ATOM | 5972 | N | LEU | B | 419 | 2.443 | 34.862 | 34.704 | 1.00 | 28.01 | | N |
| ANISOU | 5972 | N | LEU | B | 419 | 2959 | 4192 | 3493 | −433 | −557 | 345 | N |
| ATOM | 5973 | CA | LEU | B | 419 | 1.524 | 33.832 | 34.204 | 1.00 | 26.73 | | C |
| ANISOU | 5973 | CA | LEU | B | 419 | 2809 | 4026 | 3322 | −504 | −511 | 399 | C |
| ATOM | 5974 | C | LEU | B | 419 | 0.168 | 34.463 | 34.054 | 1.00 | 28.91 | | C |
| ANISOU | 5974 | C | LEU | B | 419 | 3014 | 4373 | 3596 | −536 | −448 | 393 | C |
| ATOM | 5975 | O | LEU | B | 419 | −0.184 | 35.354 | 34.810 | 1.00 | 30.73 | | O |
| ANISOU | 5975 | O | LEU | B | 419 | 3226 | 4665 | 3786 | −505 | −411 | 371 | O |
| ATOM | 5976 | CB | LEU | B | 419 | 1.436 | 32.617 | 35.129 | 1.00 | 21.64 | | C |
| ANISOU | 5976 | CB | LEU | B | 419 | 2257 | 3357 | 2609 | −534 | −511 | 468 | C |
| ATOM | 5977 | CG | LEU | B | 419 | 2.760 | 31.928 | 35.470 | 1.00 | 21.18 | | C |
| ANISOU | 5977 | CG | LEU | B | 419 | 2273 | 3217 | 2559 | −487 | −601 | 478 | C |
| ATOM | 5978 | CD1 | LEU | B | 419 | 2.566 | 30.791 | 36.443 | 1.00 | 21.95 | | C |
| ANISOU | 5978 | CD1 | LEU | B | 419 | 2497 | 3281 | 2563 | −511 | −605 | 555 | C |
| ATOM | 5979 | CD2 | LEU | B | 419 | 3.431 | 31.455 | 34.193 | 1.00 | 20.38 | | C |
| ANISOU | 5979 | CD2 | LEU | B | 419 | 2138 | 3038 | 2568 | −483 | −615 | 461 | C |
| ATOM | 5980 | N | TYR | B | 420 | −0.583 | 34.031 | 33.053 | 1.00 | 30.60 | | N |
| ANISOU | 5980 | N | TYR | B | 420 | 3192 | 4567 | 3868 | −590 | −452 | 404 | N |
| ATOM | 5981 | CA | TYR | B | 420 | −1.945 | 34.502 | 32.908 | 1.00 | 25.32 | | C |
| ANISOU | 5981 | CA | TYR | B | 420 | 2425 | 3949 | 3246 | −623 | −420 | 402 | C |
| ATOM | 5982 | C | TYR | B | 420 | −2.943 | 33.336 | 32.934 | 1.00 | 26.18 | | C |
| ANISOU | 5982 | C | TYR | B | 420 | 2502 | 4031 | 3414 | −718 | −403 | 463 | C |
| ATOM | 5983 | O | TYR | B | 420 | −2.607 | 32.193 | 32.648 | 1.00 | 28.97 | | O |
| ANISOU | 5983 | O | TYR | B | 420 | 2928 | 4312 | 3766 | −761 | −443 | 494 | O |
| ATOM | 5984 | CB | TYR | B | 420 | −2.082 | 35.335 | 31.625 | 1.00 | 24.85 | | C |
| ANISOU | 5984 | CB | TYR | B | 420 | 2336 | 3873 | 3235 | −593 | −481 | 349 | C |
| ATOM | 5985 | CG | TYR | B | 420 | −1.884 | 34.567 | 30.341 | 1.00 | 27.15 | | C |
| ANISOU | 5985 | CG | TYR | B | 420 | 2707 | 4070 | 3540 | −617 | −559 | 347 | C |
| ATOM | 5986 | CD1 | TYR | B | 420 | −0.616 | 34.339 | 29.838 | 1.00 | 26.71 | | C |
| ANISOU | 5986 | CD1 | TYR | B | 420 | 2755 | 3946 | 3447 | −576 | −556 | 335 | C |
| ATOM | 5987 | CD2 | TYR | B | 420 | −2.970 | 34.074 | 29.626 | 1.00 | 23.16 | | C |
| ANISOU | 5987 | CD2 | TYR | B | 420 | 2176 | 3528 | 3098 | −675 | −637 | 353 | C |
| ATOM | 5988 | CE1 | TYR | B | 420 | −0.429 | 33.628 | 28.663 | 1.00 | 29.07 | | C |
| ANISOU | 5988 | CE1 | TYR | B | 420 | 3168 | 4145 | 3734 | −582 | −600 | 330 | C |
| ATOM | 5989 | CE2 | TYR | B | 420 | −2.792 | 33.378 | 28.461 | 1.00 | 22.75 | | C |
| ANISOU | 5989 | CE2 | TYR | B | 420 | 2245 | 3371 | 3028 | −687 | −727 | 341 | C |
| ATOM | 5990 | CZ | TYR | B | 420 | −1.518 | 33.153 | 27.983 | 1.00 | 26.56 | | C |
| ANISOU | 5990 | CZ | TYR | B | 420 | 2867 | 3789 | 3436 | −635 | −694 | 330 | C |
| ATOM | 5991 | OH | TYR | B | 420 | −1.337 | 32.454 | 26.811 | 1.00 | 28.25 | | O |
| ANISOU | 5991 | OH | TYR | B | 420 | 3241 | 3884 | 3609 | −630 | −757 | 314 | O |
| ATOM | 5992 | N | LYS | B | 421 | −4.174 | 33.644 | 33.298 | 1.00 | 29.11 | | N |
| ANISOU | 5992 | N | LYS | B | 421 | 2752 | 4448 | 3859 | −750 | −336 | 478 | N |
| ATOM | 5993 | CA | LYS | B | 421 | −5.218 | 32.650 | 33.377 | 1.00 | 27.74 | | C |
| ANISOU | 5993 | CA | LYS | B | 421 | 2503 | 4238 | 3799 | −853 | −303 | 539 | C |
| ATOM | 5994 | C | LYS | B | 421 | −5.667 | 32.278 | 31.974 | 1.00 | 31.77 | | C |
| ANISOU | 5994 | C | LYS | B | 421 | 2972 | 4674 | 4424 | −902 | −463 | 510 | C |
| ATOM | 5995 | O | LYS | B | 421 | −6.052 | 33.148 | 31.175 | 1.00 | 26.56 | | O |
| ANISOU | 5995 | O | LYS | B | 421 | 2250 | 4024 | 3817 | −863 | −549 | 454 | O |
| ATOM | 5996 | CB | LYS | B | 421 | −6.392 | 33.176 | 34.206 | 1.00 | 30.95 | | C |
| ANISOU | 5996 | CB | LYS | B | 421 | 2763 | 4704 | 4291 | −864 | −151 | 564 | C |
| ATOM | 5997 | CG | LYS | B | 421 | −7.342 | 32.101 | 34.684 | 1.00 | 47.29 | | C |
| ANISOU | 5997 | CG | LYS | B | 421 | 4754 | 6727 | 6487 | −975 | −44 | 651 | C |
| ATOM | 5998 | CD | LYS | B | 421 | −6.646 | 31.135 | 35.640 | 1.00 | 60.67 | | C |
| ANISOU | 5998 | CD | LYS | B | 421 | 6633 | 8389 | 8032 | −995 | 46 | 725 | C |
| ATOM | 5999 | CE | LYS | B | 421 | −7.643 | 30.199 | 36.298 | 1.00 | 69.48 | | C |
| ANISOU | 5999 | CE | LYS | B | 421 | 7683 | 9451 | 9266 | −1104 | 215 | 827 | C |
| ATOM | 6000 | NZ | LYS | B | 421 | −6.969 | 29.036 | 36.938 | 1.00 | 74.11 | | N |
| ANISOU | 6000 | NZ | LYS | B | 421 | 8474 | 9968 | 9718 | −1135 | 250 | 906 | N |
| ATOM | 6001 | N | LYS | B | 422 | −5.555 | 30.993 | 31.649 | 1.00 | 26.50 | | N |
| ANISOU | 6001 | N | LYS | B | 422 | 2377 | 3916 | 3777 | −976 | −521 | 544 | N |
| ATOM | 6002 | CA | LYS | B | 422 | −6.120 | 30.480 | 30.413 | 1.00 | 26.79 | | C |
| ANISOU | 6002 | CA | LYS | B | 422 | 2403 | 3856 | 3921 | −1032 | −691 | 516 | C |
| ATOM | 6003 | C | LYS | B | 422 | −6.876 | 29.228 | 30.741 | 1.00 | 36.66 | | C |
| ANISOU | 6003 | C | LYS | B | 422 | 3592 | 5030 | 5306 | −1159 | −679 | 582 | C |
| ATOM | 6004 | O | LYS | B | 422 | −6.274 | 28.217 | 31.102 | 1.00 | 39.51 | | O |
| ANISOU | 6004 | O | LYS | B | 422 | 4076 | 5339 | 5598 | −1191 | −642 | 628 | O |
| ATOM | 6005 | CB | LYS | B | 422 | −5.066 | 30.183 | 29.371 | 1.00 | 26.86 | | C |
| ANISOU | 6005 | CB | LYS | B | 422 | 2612 | 3787 | 3806 | −980 | −801 | 470 | C |
| ATOM | 6006 | CG | LYS | B | 422 | −5.656 | 29.469 | 28.170 | 1.00 | 32.28 | | C |
| ANISOU | 6006 | CG | LYS | B | 422 | 3353 | 4345 | 4567 | −1036 | −990 | 440 | C |
| ATOM | 6007 | CD | LYS | B | 422 | −4.651 | 29.307 | 27.052 | 1.00 | 33.82 | | C |
| ANISOU | 6007 | CD | LYS | B | 422 | 3785 | 4452 | 4613 | −961 | −1066 | 388 | C |
| ATOM | 6008 | CE | LYS | B | 422 | −5.347 | 29.209 | 25.695 | 1.00 | 41.49 | | C |
| ANISOU | 6008 | CE | LYS | B | 422 | 4848 | 5305 | 5611 | −970 | −1286 | 329 | C |
| ATOM | 6009 | NZ | LYS | B | 422 | −4.600 | 29.983 | 24.655 | 1.00 | 45.78 | | N |
| ANISOU | 6009 | NZ | LYS | B | 422 | 5592 | 5814 | 5988 | −849 | −1306 | 273 | N |
| ATOM | 6010 | N | GLU | B | 423 | −8.193 | 29.303 | 30.607 | 1.00 | 42.15 | | N |
| ANISOU | 6010 | N | GLU | B | 423 | 4088 | 5707 | 6220 | −1233 | −716 | 587 | N |
| ATOM | 6011 | CA | GLU | B | 423 | −9.070 | 28.253 | 31.080 | 1.00 | 50.21 | | C |
| ANISOU | 6011 | CA | GLU | B | 423 | 4991 | 6653 | 7432 | −1370 | −660 | 662 | C |
| ATOM | 6012 | C | GLU | B | 423 | −8.767 | 28.076 | 32.561 | 1.00 | 50.37 | | C |
| ANISOU | 6012 | C | GLU | B | 423 | 5047 | 6737 | 7354 | −1368 | −391 | 752 | C |
| ATOM | 6013 | O | GLU | B | 423 | −8.838 | 29.031 | 33.340 | 1.00 | 54.73 | | O |
| ANISOU | 6013 | O | GLU | B | 423 | 5546 | 7396 | 7852 | −1297 | −233 | 756 | O |
| ATOM | 6014 | CB | GLU | B | 423 | −8.843 | 26.958 | 30.298 | 1.00 | 48.92 | | C |
| ANISOU | 6014 | CB | GLU | B | 423 | 4964 | 6341 | 7283 | −1446 | −831 | 658 | C |
| ATOM | 6015 | CG | GLU | B | 423 | −9.184 | 27.055 | 28.820 | 1.00 | 59.48 | | C |
| ANISOU | 6015 | CG | GLU | B | 423 | 6328 | 7586 | 8687 | −1442 | −1119 | 565 | C |
| ATOM | 6016 | CD | GLU | B | 423 | −10.615 | 27.495 | 28.553 | 1.00 | 79.16 | | C |
| ANISOU | 6016 | CD | GLU | B | 423 | 8591 | 10057 | 11429 | −1459 | −1190 | 528 | C |
| ATOM | 6017 | OE1 | GLU | B | 423 | −11.500 | 27.255 | 29.406 | 1.00 | 84.33 | | O |
| ANISOU | 6017 | OE1 | GLU | B | 423 | 9049 | 10719 | 12274 | −1525 | −1025 | 582 | O |
| ATOM | 6018 | OE2 | GLU | B | 423 | −10.852 | 28.097 | 27.483 | 1.00 | 88.09 | | O |
| ANISOU | 6018 | OE2 | GLU | B | 423 | 9773 | 11156 | 12542 | −1377 | −1384 | 438 | O |
| ATOM | 6019 | N | SER | B | 424 | −8.391 | 26.872 | 32.947 | 1.00 | 43.52 | | N |
| ANISOU | 6019 | N | SER | B | 424 | 4306 | 5790 | 6441 | −1434 | −350 | 820 | N |
| ATOM | 6020 | CA | SER | B | 424 | −8.112 | 26.613 | 34.347 | 1.00 | 52.65 | | C |
| ANISOU | 6020 | CA | SER | B | 424 | 5549 | 6978 | 7477 | −1426 | −116 | 913 | C |
| ATOM | 6021 | C | SER | B | 424 | −6.612 | 26.507 | 34.602 | 1.00 | 46.38 | | C |
| ANISOU | 6021 | C | SER | B | 424 | 5004 | 6202 | 6415 | −1323 | −151 | 900 | C |
| ATOM | 6022 | O | SER | B | 424 | −6.200 | 26.067 | 35.670 | 1.00 | 50.93 | | O |
| ANISOU | 6022 | O | SER | B | 424 | 5718 | 6770 | 6863 | −1310 | −24 | 975 | O |
| ATOM | 6023 | CB | SER | B | 424 | −8.816 | 25.342 | 34.813 | 1.00 | 58.27 | | C |
| ANISOU | 6023 | CB | SER | B | 424 | 6229 | 7572 | 8340 | −1573 | −12 | 1021 | C |
| ATOM | 6024 | OG | SER | B | 424 | −8.675 | 24.322 | 33.846 | 1.00 | 68.06 | | O |
| ANISOU | 6024 | OG | SER | B | 424 | 7524 | 8681 | 9653 | −1647 | −219 | 999 | O |
| ATOM | 6025 | N | PHE | B | 425 | −5.805 | 26.898 | 33.618 | 1.00 | 34.49 | | N |
| ANISOU | 6025 | N | PHE | B | 425 | 3560 | 4705 | 4838 | −1246 | −323 | 808 | N |
| ATOM | 6026 | CA | PHE | B | 425 | −4.350 | 26.863 | 33.760 | 1.00 | 25.93 | | C |
| ANISOU | 6026 | CA | PHE | B | 425 | 2661 | 3626 | 3564 | −1144 | −360 | 788 | C |
| ATOM | 6027 | C | PHE | B | 425 | −3.748 | 28.267 | 33.879 | 1.00 | 32.34 | | C |
| ANISOU | 6027 | C | PHE | B | 425 | 3461 | 4550 | 4279 | −1023 | −351 | 721 | C |
| ATOM | 6028 | O | PHE | B | 425 | −4.419 | 29.269 | 33.641 | 1.00 | 29.17 | | O |
| ANISOU | 6028 | O | PHE | B | 425 | 2928 | 4216 | 3939 | −1010 | −337 | 680 | O |
| ATOM | 6029 | CB | PHE | B | 425 | −3.703 | 26.136 | 32.568 | 1.00 | 27.86 | | C |
| ANISOU | 6029 | CB | PHE | B | 425 | 3008 | 3766 | 3811 | −1140 | −520 | 743 | C |
| ATOM | 6030 | CG | PHE | B | 425 | −3.912 | 24.640 | 32.558 | 1.00 | 26.64 | | C |
| ANISOU | 6030 | CG | PHE | B | 425 | 2931 | 3478 | 3714 | −1237 | −546 | 804 | C |
| ATOM | 6031 | CD1 | PHE | B | 425 | −5.068 | 24.080 | 32.019 | 1.00 | 31.06 | | C |
| ANISOU | 6031 | CD1 | PHE | B | 425 | 3395 | 3956 | 4450 | −1363 | −607 | 814 | C |
| ATOM | 6032 | CD2 | PHE | B | 425 | −2.935 | 23.795 | 33.063 | 1.00 | 26.64 | | C |
| ANISOU | 6032 | CD2 | PHE | B | 425 | 3095 | 3415 | 3612 | −1201 | −534 | 848 | C |
| ATOM | 6033 | CE1 | PHE | B | 425 | −5.259 | 22.703 | 32.002 | 1.00 | 35.25 | | C |
| ANISOU | 6033 | CE1 | PHE | B | 425 | 4000 | 4343 | 5050 | −1462 | −640 | 868 | C |
| ATOM | 6034 | CE2 | PHE | B | 425 | −3.113 | 22.403 | 33.049 | 1.00 | 44.41 | | C |
| ANISOU | 6034 | CE2 | PHE | B | 425 | 5433 | 5526 | 5916 | −1288 | −560 | 907 | C |
| ATOM | 6035 | CZ | PHE | B | 425 | −4.280 | 21.858 | 32.516 | 1.00 | 37.44 | | C |
| ANISOU | 6035 | CZ | PHE | B | 425 | 4461 | 4561 | 5204 | −1424 | −607 | 917 | C |
| ATOM | 6036 | N | TRP | B | 426 | −2.469 | 28.314 | 34.233 | 1.00 | 32.63 | | N |
| ANISOU | 6036 | N | TRP | B | 426 | 3625 | 4587 | 4187 | −935 | −375 | 709 | N |
| ATOM | 6037 | CA | TRP | B | 426 | −1.701 | 29.547 | 34.304 | 1.00 | 22.68 | | C |
| ANISOU | 6037 | CA | TRP | B | 426 | 2358 | 3399 | 2859 | −828 | −392 | 643 | C |
| ATOM | 6038 | C | TRP | B | 426 | −0.542 | 29.476 | 33.331 | 1.00 | 21.71 | | C |
| ANISOU | 6038 | C | TRP | B | 426 | 2290 | 3219 | 2741 | −770 | −490 | 589 | C |
| ATOM | 6039 | O | TRP | B | 426 | 0.371 | 28.690 | 33.532 | 1.00 | 27.06 | | O |
| ANISOU | 6039 | O | TRP | B | 426 | 3062 | 3828 | 3391 | −743 | −523 | 611 | O |
| ATOM | 6040 | CB | TRP | B | 426 | −1.194 | 29.781 | 35.726 | 1.00 | 23.07 | | C |
| ANISOU | 6040 | CB | TRP | B | 426 | 2499 | 3484 | 2783 | −770 | −337 | 672 | C |
| ATOM | 6041 | CG | TRP | B | 426 | −2.281 | 30.123 | 36.667 | 1.00 | 25.45 | | C |
| ANISOU | 6041 | CG | TRP | B | 426 | 2770 | 3843 | 3056 | −799 | −191 | 715 | C |
| ATOM | 6042 | CD1 | TRP | B | 426 | −2.985 | 29.267 | 37.465 | 1.00 | 32.29 | | C |
| ANISOU | 6042 | CD1 | TRP | B | 426 | 3691 | 4674 | 3904 | −866 | −67 | 810 | C |
| ATOM | 6043 | CD2 | TRP | B | 426 | −2.803 | 31.426 | 36.912 | 1.00 | 30.04 | | C |
| ANISOU | 6043 | CD2 | TRP | B | 426 | 3265 | 4514 | 3634 | −755 | −122 | 668 | C |
| ATOM | 6044 | NE1 | TRP | B | 426 | −3.921 | 29.961 | 38.196 | 1.00 | 36.82 | | N |
| ANISOU | 6044 | NE1 | TRP | B | 426 | 4213 | 5311 | 4468 | −864 | 101 | 827 | N |
| ATOM | 6045 | CE2 | TRP | B | 426 | −3.830 | 31.295 | 37.873 | 1.00 | 38.28 | | C |
| ANISOU | 6045 | CE2 | TRP | B | 426 | 4310 | 5576 | 4660 | −790 | 60 | 735 | C |
| ATOM | 6046 | CE3 | TRP | B | 426 | −2.499 | 32.700 | 36.417 | 1.00 | 24.51 | | C |
| ANISOU | 6046 | CE3 | TRP | B | 426 | 2495 | 3868 | 2949 | −685 | −182 | 579 | C |
| ATOM | 6047 | CZ2 | TRP | B | 426 | −4.556 | 32.386 | 38.346 | 1.00 | 30.50 | | C |
| ANISOU | 6047 | CZ2 | TRP | B | 426 | 3253 | 4662 | 3672 | −747 | 186 | 708 | C |
| ATOM | 6048 | CZ3 | TRP | B | 426 | −3.222 | 33.780 | 36.882 | 1.00 | 29.45 | | C |
| ANISOU | 6048 | CZ3 | TRP | B | 426 | 3056 | 4565 | 3569 | −649 | −85 | 551 | C |
| ATOM | 6049 | CH2 | TRP | B | 426 | −4.238 | 33.617 | 37.838 | 1.00 | 32.26 | | C |
| ANISOU | 6049 | CH2 | TRP | B | 426 | 3410 | 4940 | 3907 | −674 | 97 | 611 | C |
| ATOM | 6050 | N | CYS | B | 427 | −0.564 | 30.299 | 32.285 | 1.00 | 20.99 | | N |
| ANISOU | 6050 | N | CYS | B | 427 | 2147 | 3141 | 2688 | −741 | −523 | 524 | N |
| ATOM | 6051 | CA | CYS | B | 427 | 0.378 | 30.126 | 31.183 | 1.00 | 27.58 | | C |
| ANISOU | 6051 | CA | CYS | B | 427 | 3053 | 3895 | 3532 | −692 | −569 | 483 | C |
| ATOM | 6052 | C | CYS | B | 427 | 1.425 | 31.250 | 31.085 | 1.00 | 30.50 | | C |
| ANISOU | 6052 | C | CYS | B | 427 | 3400 | 4288 | 3902 | −599 | −547 | 433 | C |
| ATOM | 6053 | O | CYS | B | 427 | 1.137 | 32.399 | 31.403 | 1.00 | 27.98 | | O |
| ANISOU | 6053 | O | CYS | B | 427 | 3007 | 4047 | 3578 | −579 | −528 | 407 | O |
| ATOM | 6054 | CB | CYS | B | 427 | −0.391 | 30.014 | 29.871 | 1.00 | 20.73 | | C |
| ANISOU | 6054 | CB | CYS | B | 427 | 2207 | 2975 | 2692 | −729 | −626 | 453 | C |
| ATOM | 6055 | SG | CYS | B | 427 | −1.601 | 28.678 | 29.807 | 1.00 | 34.11 | | S |
| ANISOU | 6055 | SG | CYS | B | 427 | 3907 | 4604 | 4449 | −854 | −690 | 500 | S |
| ATOM | 6056 | N | LYS | B | 428 | 2.633 | 30.900 | 30.634 | 1.00 | 28.49 | | N |
| ANISOU | 6056 | N | LYS | B | 428 | 3197 | 3949 | 3677 | −542 | −540 | 420 | N |
| ATOM | 6057 | CA | LYS | B | 428 | 3.756 | 31.834 | 30.596 | 1.00 | 27.16 | | C |
| ANISOU | 6057 | CA | LYS | B | 428 | 2979 | 3774 | 3567 | −465 | −508 | 381 | C |
| ATOM | 6058 | C | LYS | B | 428 | 3.563 | 32.934 | 29.547 | 1.00 | 24.58 | | C |
| ANISOU | 6058 | C | LYS | B | 428 | 2646 | 3450 | 3245 | −443 | −460 | 339 | C |
| ATOM | 6059 | O | LYS | B | 428 | 3.532 | 32.657 | 28.351 | 1.00 | 27.94 | | O |
| ANISOU | 6059 | O | LYS | B | 428 | 3168 | 3798 | 3650 | −433 | −429 | 330 | O |
| ATOM | 6060 | CB | LYS | B | 428 | 5.086 | 31.078 | 30.350 | 1.00 | 31.53 | | C |
| ANISOU | 6060 | CB | LYS | B | 428 | 3561 | 4216 | 4203 | −408 | −490 | 385 | C |
| ATOM | 6061 | CG | LYS | B | 428 | 6.327 | 31.990 | 30.440 | 1.00 | 25.91 | | C |
| ANISOU | 6061 | CG | LYS | B | 428 | 2747 | 3477 | 3621 | −337 | −459 | 351 | C |
| ATOM | 6062 | CD | LYS | B | 428 | 7.713 | 31.292 | 30.398 | 1.00 | 23.47 | | C |
| ANISOU | 6062 | CD | LYS | B | 428 | 2407 | 3051 | 3461 | −271 | −444 | 354 | C |
| ATOM | 6063 | CE | LYS | B | 428 | 8.121 | 30.581 | 29.110 | 1.00 | 27.55 | | C |
| ANISOU | 6063 | CE | LYS | B | 428 | 3007 | 3449 | 4010 | −235 | −319 | 354 | C |
| ATOM | 6064 | NZ | LYS | B | 428 | 7.459 | 30.904 | 27.839 | 1.00 | 33.08 | | N |
| ANISOU | 6064 | NZ | LYS | B | 428 | 3827 | 4135 | 4606 | −248 | −221 | 339 | N |
| ATOM | 6065 | N | GLY | B | 429 | 3.458 | 34.176 | 30.014 | 1.00 | 20.79 | | N |
| ANISOU | 6065 | N | GLY | B | 429 | 2082 | 3041 | 2774 | −428 | −458 | 314 | N |
| ATOM | 6066 | CA | GLY | B | 429 | 3.267 | 35.331 | 29.151 | 1.00 | 23.26 | | C |
| ANISOU | 6066 | CA | GLY | B | 429 | 2397 | 3351 | 3090 | −403 | −417 | 282 | C |
| ATOM | 6067 | C | GLY | B | 429 | 4.564 | 36.044 | 28.789 | 1.00 | 28.98 | | C |
| ANISOU | 6067 | C | GLY | B | 429 | 3094 | 4004 | 3915 | −345 | −338 | 260 | C |
| ATOM | 6068 | O | GLY | B | 429 | 4.674 | 37.277 | 28.847 | 1.00 | 27.88 | | O |
| ANISOU | 6068 | O | GLY | B | 429 | 2901 | 3881 | 3812 | −326 | −318 | 234 | O |
| ATOM | 6069 | N | ILE | B | 430 | 5.574 | 35.262 | 28.426 | 1.00 | 33.64 | | N |
| ANISOU | 6069 | N | ILE | B | 430 | 3710 | 4497 | 4575 | −318 | −281 | 273 | N |
| ATOM | 6070 | CA | ILE | B | 430 | 6.854 | 35.816 | 28.008 | 1.00 | 22.42 | | C |
| ANISOU | 6070 | CA | ILE | B | 430 | 2234 | 2981 | 3303 | −266 | −169 | 262 | C |
| ATOM | 6071 | C | ILE | B | 430 | 7.215 | 35.227 | 26.657 | 1.00 | 35.60 | | C |
| ANISOU | 6071 | C | ILE | B | 430 | 4042 | 4529 | 4955 | −230 | −27 | 276 | C |
| ATOM | 6072 | O | ILE | B | 430 | 7.182 | 33.995 | 26.481 | 1.00 | 41.53 | | O |
| ANISOU | 6072 | O | ILE | B | 430 | 4877 | 5242 | 5662 | −228 | −40 | 290 | O |
| ATOM | 6073 | CB | ILE | B | 430 | 7.951 | 35.510 | 29.016 | 1.00 | 23.92 | | C |
| ANISOU | 6073 | CB | ILE | B | 430 | 2287 | 3146 | 3655 | −246 | −224 | 259 | C |
| ATOM | 6074 | CG1 | ILE | B | 430 | 7.511 | 35.912 | 30.428 | 1.00 | 29.35 | | C |
| ANISOU | 6074 | CG1 | ILE | B | 430 | 2915 | 3940 | 4297 | −272 | −382 | 243 | C |
| ATOM | 6075 | CG2 | ILE | B | 430 | 9.223 | 36.204 | 28.614 | 1.00 | 24.15 | | C |
| ANISOU | 6075 | CG2 | ILE | B | 430 | 2206 | 3067 | 3904 | −205 | −109 | 245 | C |
| ATOM | 6076 | CD1 | ILE | B | 430 | 8.478 | 35.515 | 31.524 | 1.00 | 31.96 | | C |
| ANISOU | 6076 | CD1 | ILE | B | 430 | 3161 | 4235 | 4746 | −244 | −502 | 238 | C |
| ATOM | 6077 | N | GLU | B | 431 | 7.562 | 36.090 | 25.706 | 1.00 | 35.58 | | N |
| ANISOU | 6077 | N | GLU | B | 431 | 4093 | 4450 | 4975 | −195 | 119 | 273 | N |
| ATOM | 6078 | CA | GLU | B | 431 | 7.899 | 35.648 | 24.350 | 1.00 | 34.55 | | C |
| ANISOU | 6078 | CA | GLU | B | 431 | 4154 | 4184 | 4789 | −142 | 290 | 287 | C |
| ATOM | 6079 | C | GLU | B | 431 | 9.243 | 36.218 | 23.910 | 1.00 | 38.17 | | C |
| ANISOU | 6079 | C | GLU | B | 431 | 4542 | 4517 | 5444 | −90 | 521 | 300 | C |
| ATOM | 6080 | O | GLU | B | 431 | 9.738 | 37.187 | 24.488 | 1.00 | 38.00 | | O |
| ANISOU | 6080 | O | GLU | B | 431 | 4335 | 4513 | 5592 | −107 | 524 | 295 | O |
| ATOM | 6081 | CB | GLU | B | 431 | 6.843 | 36.085 | 23.324 | 1.00 | 38.47 | | C |
| ANISOU | 6081 | CB | GLU | B | 431 | 4876 | 4669 | 5071 | −139 | 274 | 284 | C |
| ATOM | 6082 | CG | GLU | B | 431 | 5.396 | 35.690 | 23.572 | 1.00 | 53.79 | | C |
| ANISOU | 6082 | CG | GLU | B | 431 | 6864 | 6711 | 6863 | −194 | 52 | 270 | C |
| ATOM | 6083 | CD | GLU | B | 431 | 4.481 | 36.125 | 22.417 | 1.00 | 67.84 | | C |
| ANISOU | 6083 | CD | GLU | B | 431 | 8872 | 8440 | 8463 | −172 | 9 | 261 | C |
| ATOM | 6084 | OE1 | GLU | B | 431 | 3.489 | 35.421 | 22.124 | 1.00 | 74.71 | | O |
| ANISOU | 6084 | OE1 | GLU | B | 431 | 9851 | 9313 | 9222 | −199 | −149 | 247 | O |
| ATOM | 6085 | OE2 | GLU | B | 431 | 4.763 | 37.173 | 21.791 | 1.00 | 69.92 | | O |
| ANISOU | 6085 | OE2 | GLU | B | 431 | 9214 | 8644 | 8708 | −126 | 121 | 268 | O |
| ATOM | 6086 | N | LYS | B | 432 | 9.806 | 35.605 | 22.870 | 1.00 | 39.61 | | N |
| ANISOU | 6086 | N | LYS | B | 432 | 4880 | 4557 | 5611 | −27 | 721 | 317 | N |
| ATOM | 6087 | CA | LYS | B | 432 | 10.939 | 36.142 | 22.135 | 1.00 | 35.98 | | C |
| ANISOU | 6087 | CA | LYS | B | 432 | 4411 | 3946 | 5315 | 31 | 1016 | 342 | C |
| ATOM | 6088 | C | LYS | B | 432 | 10.503 | 37.438 | 21.457 | 1.00 | 39.08 | | C |
| ANISOU | 6088 | C | LYS | B | 432 | 4935 | 4318 | 5598 | 27 | 1095 | 357 | C |
| ATOM | 6089 | O | LYS | B | 432 | 9.347 | 37.584 | 21.062 | 1.00 | 47.72 | | O |
| ANISOU | 6089 | O | LYS | B | 432 | 6233 | 5464 | 6433 | 16 | 964 | 348 | O |
| ATOM | 6090 | CB | LYS | B | 432 | 11.443 | 35.128 | 21.103 | 1.00 | 37.69 | | C |
| ANISOU | 6090 | CB | LYS | B | 432 | 4835 | 4009 | 5477 | 115 | 1234 | 356 | C |
| ATOM | 6091 | CG | LYS | B | 432 | 12.193 | 33.955 | 21.691 | 1.00 | 47.28 | | C |
| ANISOU | 6091 | CG | LYS | B | 432 | 5892 | 5197 | 6873 | 141 | 1216 | 348 | C |
| ATOM | 6092 | CD | LYS | B | 432 | 12.566 | 32.947 | 20.615 | 1.00 | 53.68 | | C |
| ANISOU | 6092 | CD | LYS | B | 432 | 6950 | 5848 | 7596 | 236 | 1435 | 352 | C |
| ATOM | 6093 | CE | LYS | B | 432 | 11.388 | 32.018 | 20.339 | 1.00 | 50.08 | | C |
| ANISOU | 6093 | CE | LYS | B | 432 | 6772 | 5435 | 6823 | 219 | 1232 | 325 | C |
| ATOM | 6094 | NZ | LYS | B | 432 | 11.703 | 31.046 | 19.265 | 1.00 | 56.46 | | N |
| ANISOU | 6094 | NZ | LYS | B | 432 | 7870 | 6070 | 7511 | 318 | 1424 | 317 | N |
| ATOM | 6095 | N | GLN | B | 433 | 11.424 | 38.377 | 21.312 | 1.00 | 33.78 | | N |
| ANISOU | 6095 | N | GLN | B | 433 | 4140 | 3552 | 5141 | 35 | 1300 | 383 | N |
| ATOM | 6096 | CA | GLN | B | 433 | 11.058 | 39.669 | 20.776 | 1.00 | 35.44 | | C |
| ANISOU | 6096 | CA | GLN | B | 433 | 4466 | 3734 | 5267 | 28 | 1369 | 404 | C |
| ATOM | 6097 | C | GLN | B | 433 | 11.036 | 39.605 | 19.271 | 1.00 | 45.16 | | C |
| ANISOU | 6097 | C | GLN | B | 433 | 6066 | 4805 | 6287 | 106 | 1621 | 445 | C |
| ATOM | 6098 | O | GLN | B | 433 | 11.588 | 38.697 | 18.671 | 1.00 | 48.47 | | O |
| ANISOU | 6098 | O | GLN | B | 433 | 6605 | 5114 | 6696 | 169 | 1807 | 457 | O |
| ATOM | 6099 | CB | GLN | B | 433 | 12.018 | 40.764 | 21.266 | 1.00 | 33.04 | | C |
| ANISOU | 6099 | CB | GLN | B | 433 | 3885 | 3377 | 5294 | −8 | 1477 | 418 | C |
| ATOM | 6100 | CG | GLN | B | 433 | 13.491 | 40.583 | 20.899 | 1.00 | 32.70 | | C |
| ANISOU | 6100 | CG | GLN | B | 433 | 3703 | 3155 | 5566 | 27 | 1797 | 455 | C |
| ATOM | 6101 | CD | GLN | B | 433 | 14.384 | 41.617 | 21.598 | 1.00 | 42.62 | | C |
| ANISOU | 6101 | CD | GLN | B | 433 | 4620 | 4363 | 7211 | −31 | 1820 | 455 | C |
| ATOM | 6102 | OE1 | GLN | B | 433 | 14.037 | 42.137 | 22.658 | 1.00 | 47.88 | | O |
| ANISOU | 6102 | OE1 | GLN | B | 433 | 5118 | 5149 | 7924 | −92 | 1536 | 408 | O |
| ATOM | 6103 | NE2 | GLN | B | 433 | 15.532 | 41.908 | 21.007 | 1.00 | 38.69 | | N |
| ANISOU | 6103 | NE2 | GLN | B | 433 | 4026 | 3673 | 7002 | −11 | 2161 | 505 | N |
| ATOM | 6104 | N | VAL | B | 434 | 10.370 | 40.574 | 18.667 | 1.00 | 58.71 | | N |
| ANISOU | 6104 | N | VAL | B | 434 | 7990 | 6499 | 7819 | 114 | 1617 | 464 | N |
| ATOM | 6105 | CA | VAL | B | 434 | 10.369 | 40.704 | 17.223 | 1.00 | 71.48 | | C |
| ANISOU | 6105 | CA | VAL | B | 434 | 10012 | 7939 | 9209 | 199 | 1856 | 509 | C |
| ATOM | 6106 | C | VAL | B | 434 | 11.030 | 42.016 | 16.832 | 1.00 | 68.94 | | C |
| ANISOU | 6106 | C | VAL | B | 434 | 9684 | 7487 | 9021 | 201 | 2128 | 572 | C |
| ATOM | 6107 | O | VAL | B | 434 | 10.813 | 43.038 | 17.481 | 1.00 | 74.57 | | O |
| ANISOU | 6107 | O | VAL | B | 434 | 10206 | 8276 | 9851 | 138 | 1998 | 565 | O |
| ATOM | 6108 | CB | VAL | B | 434 | 8.932 | 40.661 | 16.670 | 1.00 | 81.07 | | C |
| ANISOU | 6108 | CB | VAL | B | 434 | 11555 | 9198 | 10050 | 223 | 1595 | 484 | C |
| ATOM | 6109 | CG1 | VAL | B | 434 | 8.936 | 40.642 | 15.150 | 1.00 | 81.05 | | C |
| ANISOU | 6109 | CG1 | VAL | B | 434 | 12044 | 8989 | 9761 | 330 | 1806 | 524 | C |
| ATOM | 6110 | CG2 | VAL | B | 434 | 8.190 | 39.453 | 17.233 | 1.00 | 84.92 | | C |
| ANISOU | 6110 | CG2 | VAL | B | 434 | 11980 | 9822 | 10464 | 190 | 1297 | 423 | C |
| ATOM | 6111 | N | ASN | B | 435 | 11.859 | 41.965 | 15.795 | 1.00 | 68.79 | | N |
| ANISOU | 6111 | N | ASN | B | 435 | 9879 | 7260 | 8999 | 275 | 2523 | 633 | N |
| ATOM | 6112 | CA | ASN | B | 435 | 12.459 | 43.153 | 15.193 | 1.00 | 74.92 | | C |
| ANISOU | 6112 | CA | ASN | B | 435 | 10731 | 7866 | 9868 | 285 | 2845 | 713 | C |
| ATOM | 6113 | C | ASN | B | 435 | 13.398 | 43.887 | 16.138 | 1.00 | 68.09 | | C |
| ANISOU | 6113 | C | ASN | B | 435 | 9386 | 7010 | 9474 | 193 | 2917 | 722 | C |
| ATOM | 6114 | O | ASN | B | 435 | 13.598 | 45.099 | 15.999 | 1.00 | 61.43 | | O |
| ANISOU | 6114 | O | ASN | B | 435 | 8526 | 6081 | 8735 | 159 | 3041 | 770 | O |
| ATOM | 6115 | CB | ASN | B | 435 | 11.366 | 44.117 | 14.713 | 1.00 | 85.55 | | C |
| ANISOU | 6115 | CB | ASN | B | 435 | 12380 | 9217 | 10906 | 298 | 2679 | 727 | C |
| ATOM | 6116 | CG | ASN | B | 435 | 10.450 | 43.496 | 13.670 | 1.00 | 89.74 | | C |
| ANISOU | 6116 | CG | ASN | B | 435 | 13420 | 9698 | 10979 | 397 | 2580 | 717 | C |
| ATOM | 6117 | OD1 | ASN | B | 435 | 10.909 | 42.848 | 12.723 | 1.00 | 92.54 | | O |
| ANISOU | 6117 | OD1 | ASN | B | 435 | 14086 | 9888 | 11187 | 487 | 2854 | 747 | O |
| ATOM | 6118 | ND2 | ASN | B | 435 | 9.141 | 43.686 | 13.847 | 1.00 | 85.25 | | N |
| ANISOU | 6118 | ND2 | ASN | B | 435 | 12938 | 9257 | 10194 | 385 | 2178 | 668 | N |
| ATOM | 6119 | N | ASN | B | 436 | 13.971 | 43.152 | 17.088 | 1.00 | 63.34 | | N |
| ANISOU | 6119 | N | ASN | B | 436 | 8414 | 6495 | 9158 | 154 | 2818 | 674 | N |
| ATOM | 6120 | CA | ASN | B | 436 | 14.831 | 43.737 | 18.113 | 1.00 | 60.71 | | C |
| ANISOU | 6120 | CA | ASN | B | 436 | 7612 | 6171 | 9283 | 67 | 2792 | 662 | C |
| ATOM | 6121 | C | ASN | B | 436 | 14.076 | 44.798 | 18.931 | 1.00 | 56.69 | | C |
| ANISOU | 6121 | C | ASN | B | 436 | 6993 | 5797 | 8748 | −12 | 2467 | 622 | C |
| ATOM | 6122 | O | ASN | B | 436 | 14.581 | 45.893 | 19.186 | 1.00 | 58.99 | | O |
| ANISOU | 6122 | O | ASN | B | 436 | 7103 | 6011 | 9298 | −70 | 2539 | 642 | O |
| ATOM | 6123 | CB | ASN | B | 436 | 16.097 | 44.326 | 17.468 | 1.00 | 65.21 | | C |
| ANISOU | 6123 | CB | ASN | B | 436 | 8124 | 6517 | 10135 | 104 | 3138 | 702 | C |
| ATOM | 6124 | CG | ASN | B | 436 | 17.168 | 44.707 | 18.485 | 1.00 | 68.19 | | C |
| ANISOU | 6124 | CG | ASN | B | 436 | 8032 | 6876 | 11001 | 44 | 3022 | 659 | C |
| ATOM | 6125 | OD1 | ASN | B | 436 | 17.003 | 44.530 | 19.697 | 1.00 | 69.10 | | O |
| ANISOU | 6125 | OD1 | ASN | B | 436 | 7869 | 7141 | 11246 | −26 | 2709 | 603 | O |
| ATOM | 6126 | ND2 | ASN | B | 436 | 18.274 | 45.241 | 17.988 | 1.00 | 69.72 | | N |
| ANISOU | 6126 | ND2 | ASN | B | 436 | 8163 | 6868 | 11458 | 78 | 3259 | 683 | N |
| ATOM | 6127 | N | LYS | B | 437 | 12.855 | 44.463 | 19.341 | 1.00 | 51.77 | | N |
| ANISOU | 6127 | N | LYS | B | 437 | 6480 | 5363 | 7827 | −12 | 2119 | 565 | N |
| ATOM | 6128 | CA | LYS | B | 437 | 12.075 | 45.342 | 20.207 | 1.00 | 43.54 | | C |
| ANISOU | 6128 | CA | LYS | B | 437 | 5329 | 4460 | 6756 | −70 | 1812 | 517 | C |
| ATOM | 6129 | C | LYS | B | 437 | 11.742 | 44.660 | 21.527 | 1.00 | 32.68 | | C |
| ANISOU | 6129 | C | LYS | B | 437 | 3718 | 3278 | 5421 | −109 | 1477 | 438 | C |
| ATOM | 6130 | O | LYS | B | 437 | 10.762 | 43.927 | 21.627 | 1.00 | 34.01 | | O |
| ANISOU | 6130 | O | LYS | B | 437 | 4015 | 3576 | 5332 | −91 | 1283 | 409 | O |
| ATOM | 6131 | CB | LYS | B | 437 | 10.780 | 45.783 | 19.522 | 1.00 | 47.21 | | C |
| ANISOU | 6131 | CB | LYS | B | 437 | 6139 | 4959 | 6840 | −30 | 1708 | 526 | C |
| ATOM | 6132 | CG | LYS | B | 437 | 10.967 | 46.430 | 18.164 | 1.00 | 54.83 | | C |
| ANISOU | 6132 | CG | LYS | B | 437 | 7430 | 5721 | 7680 | 26 | 2013 | 610 | C |
| ATOM | 6133 | CD | LYS | B | 437 | 11.850 | 47.650 | 18.248 | 1.00 | 59.49 | | C |
| ANISOU | 6133 | CD | LYS | B | 437 | 7856 | 6174 | 8572 | −24 | 2222 | 656 | C |
| ATOM | 6134 | CE | LYS | B | 437 | 11.703 | 48.532 | 17.008 | 1.00 | 64.21 | | C |
| ANISOU | 6134 | CE | LYS | B | 437 | 8829 | 6587 | 8981 | 29 | 2465 | 744 | C |
| ATOM | 6135 | NZ | LYS | B | 437 | 11.853 | 47.780 | 15.732 | 1.00 | 65.82 | | N |
| ANISOU | 6135 | NZ | LYS | B | 437 | 9415 | 6652 | 8942 | 126 | 2739 | 804 | N |
| ATOM | 6136 | N | PRO | B | 438 | 12.552 | 44.906 | 22.561 | 1.00 | 34.23 | | N |
| ANISOU | 6136 | N | PRO | B | 438 | 3579 | 3478 | 5948 | −163 | 1399 | 405 | N |
| ATOM | 6137 | CA | PRO | B | 438 | 12.167 | 44.421 | 23.895 | 1.00 | 26.21 | | C |
| ANISOU | 6137 | CA | PRO | B | 438 | 2394 | 2635 | 4928 | −192 | 1065 | 333 | C |
| ATOM | 6138 | C | PRO | B | 438 | 11.028 | 45.253 | 24.518 | 1.00 | 38.10 | | C |
| ANISOU | 6138 | C | PRO | B | 438 | 3948 | 4275 | 6253 | −216 | 822 | 288 | C |
| ATOM | 6139 | O | PRO | B | 438 | 11.035 | 46.493 | 24.527 | 1.00 | 31.42 | | O |
| ANISOU | 6139 | O | PRO | B | 438 | 3082 | 3377 | 5479 | −238 | 838 | 286 | O |
| ATOM | 6140 | CB | PRO | B | 438 | 13.456 | 44.553 | 24.703 | 1.00 | 27.36 | | C |
| ANISOU | 6140 | CB | PRO | B | 438 | 2206 | 2701 | 5488 | −229 | 1047 | 310 | C |
| ATOM | 6141 | CG | PRO | B | 438 | 14.227 | 45.649 | 23.988 | 1.00 | 35.04 | | C |
| ANISOU | 6141 | CG | PRO | B | 438 | 3133 | 3484 | 6695 | −250 | 1318 | 359 | C |
| ATOM | 6142 | CD | PRO | B | 438 | 13.860 | 45.583 | 22.546 | 1.00 | 29.74 | | C |
| ANISOU | 6142 | CD | PRO | B | 438 | 2784 | 2737 | 5780 | −197 | 1607 | 433 | C |
| ATOM | 6143 | N | ILE | B | 439 | 10.044 | 44.545 | 25.053 | 1.00 | 36.66 | | N |
| ANISOU | 6143 | N | ILE | B | 439 | 3823 | 4256 | 5851 | −209 | 610 | 255 | N |
| ATOM | 6144 | CA | ILE | B | 439 | 8.816 | 45.162 | 25.524 | 1.00 | 27.82 | | C |
| ANISOU | 6144 | CA | ILE | B | 439 | 2765 | 3263 | 4543 | −214 | 420 | 219 | C |
| ATOM | 6145 | C | ILE | B | 439 | 8.375 | 44.548 | 26.843 | 1.00 | 31.29 | | C |
| ANISOU | 6145 | C | ILE | B | 439 | 3096 | 3854 | 4939 | −232 | 186 | 168 | C |
| ATOM | 6146 | O | ILE | B | 439 | 8.222 | 43.330 | 26.953 | 1.00 | 33.25 | | O |
| ANISOU | 6146 | O | ILE | B | 439 | 3367 | 4157 | 5110 | −229 | 147 | 177 | O |
| ATOM | 6147 | CB | ILE | B | 439 | 7.684 | 44.985 | 24.489 | 1.00 | 23.92 | | C |
| ANISOU | 6147 | CB | ILE | B | 439 | 2530 | 2791 | 3766 | −176 | 440 | 248 | C |
| ATOM | 6148 | CG1 | ILE | B | 439 | 8.111 | 45.550 | 23.130 | 1.00 | 26.60 | | C |
| ANISOU | 6148 | CG1 | ILE | B | 439 | 3054 | 2959 | 4094 | −142 | 683 | 308 | C |
| ATOM | 6149 | CG2 | ILE | B | 439 | 6.379 | 45.573 | 25.005 | 1.00 | 20.87 | | C |
| ANISOU | 6149 | CG2 | ILE | B | 439 | 2163 | 2531 | 3235 | −173 | 244 | 210 | C |
| ATOM | 6150 | CD1 | ILE | B | 439 | 7.128 | 45.309 | 22.045 | 1.00 | 23.26 | | C |
| ANISOU | 6150 | CD1 | ILE | B | 439 | 2928 | 2523 | 3386 | −90 | 675 | 334 | C |
| ATOM | 6151 | N | LEU | B | 440 | 8.182 | 45.394 | 27.845 | 1.00 | 28.70 | | N |
| ANISOU | 6151 | N | LEU | B | 440 | 2676 | 3577 | 4651 | −247 | 41 | 115 | N |
| ATOM | 6152 | CA | LEU | B | 440 | 7.505 | 44.998 | 29.077 | 1.00 | 28.02 | | C |
| ANISOU | 6152 | CA | LEU | B | 440 | 2559 | 3632 | 4454 | −249 | −156 | 71 | C |
| ATOM | 6153 | C | LEU | B | 440 | 5.992 | 45.101 | 28.868 | 1.00 | 28.70 | | C |
| ANISOU | 6153 | C | LEU | B | 440 | 2768 | 3827 | 4308 | −231 | −193 | 74 | C |
| ATOM | 6154 | O | LEU | B | 440 | 5.456 | 46.207 | 28.817 | 1.00 | 27.25 | | O |
| ANISOU | 6154 | O | LEU | B | 440 | 2613 | 3647 | 4095 | −214 | −207 | 52 | O |
| ATOM | 6155 | CB | LEU | B | 440 | 7.949 | 45.895 | 30.231 | 1.00 | 21.87 | | C |
| ANISOU | 6155 | CB | LEU | B | 440 | 1671 | 2839 | 3799 | −257 | −291 | 6 | C |
| ATOM | 6156 | CG | LEU | B | 440 | 9.411 | 45.775 | 30.617 | 1.00 | 28.22 | | C |
| ANISOU | 6156 | CG | LEU | B | 440 | 2316 | 3528 | 4879 | −277 | −324 | −9 | C |
| ATOM | 6157 | CD1 | LEU | B | 440 | 9.792 | 46.965 | 31.499 | 1.00 | 33.56 | | C |
| ANISOU | 6157 | CD1 | LEU | B | 440 | 2915 | 4148 | 5688 | −288 | −469 | −83 | C |
| ATOM | 6158 | CD2 | LEU | B | 440 | 9.643 | 44.454 | 31.352 | 1.00 | 21.66 | | C |
| ANISOU | 6158 | CD2 | LEU | B | 440 | 1459 | 2750 | 4021 | −269 | −438 | −8 | C |
| ATOM | 6159 | N | GLY | B | 441 | 5.299 | 43.971 | 28.741 | 1.00 | 28.18 | | N |
| ANISOU | 6159 | N | GLY | B | 441 | 2762 | 3837 | 4107 | −235 | −217 | 99 | N |
| ATOM | 6160 | CA | GLY | B | 441 | 3.904 | 44.003 | 28.318 | 1.00 | 18.40 | | C |
| ANISOU | 6160 | CA | GLY | B | 441 | 1612 | 2669 | 2709 | −223 | −252 | 107 | C |
| ATOM | 6161 | C | GLY | B | 441 | 2.961 | 43.867 | 29.479 | 1.00 | 20.79 | | C |
| ANISOU | 6161 | C | GLY | B | 441 | 1857 | 3100 | 2941 | −229 | −356 | 79 | C |
| ATOM | 6162 | O | GLY | B | 441 | 3.375 | 44.022 | 30.619 | 1.00 | 22.51 | | O |
| ANISOU | 6162 | O | GLY | B | 441 | 2011 | 3346 | 3195 | −230 | −405 | 47 | O |
| ATOM | 6163 | N | LEU | B | 442 | 1.701 | 43.547 | 29.182 | 1.00 | 17.96 | | N |
| ANISOU | 6163 | N | LEU | B | 442 | 1531 | 2804 | 2490 | −229 | −390 | 93 | N |
| ATOM | 6164 | CA | LEU | B | 442 | 0.649 | 43.425 | 30.182 | 1.00 | 18.82 | | C |
| ANISOU | 6164 | CA | LEU | B | 442 | 1577 | 3023 | 2552 | −233 | −439 | 79 | C |
| ATOM | 6165 | C | LEU | B | 442 | 0.969 | 42.415 | 31.290 | 1.00 | 28.27 | | C |
| ANISOU | 6165 | C | LEU | B | 442 | 2748 | 4267 | 3727 | −265 | −449 | 91 | C |
| ATOM | 6166 | O | LEU | B | 442 | 0.560 | 42.607 | 32.444 | 1.00 | 32.80 | | O |
| ANISOU | 6166 | O | LEU | B | 442 | 3298 | 4906 | 4259 | −252 | −456 | 71 | O |
| ATOM | 6167 | CB | LEU | B | 442 | −0.673 | 43.058 | 29.506 | 1.00 | 18.23 | | C |
| ANISOU | 6167 | CB | LEU | B | 442 | 1506 | 2977 | 2445 | −240 | −477 | 100 | C |
| ATOM | 6168 | CG | LEU | B | 442 | −1.335 | 44.217 | 28.751 | 1.00 | 18.59 | | C |
| ANISOU | 6168 | CG | LEU | B | 442 | 1573 | 2991 | 2500 | −187 | −509 | 80 | C |
| ATOM | 6169 | CD1 | LEU | B | 442 | −2.493 | 43.766 | 27.908 | 1.00 | 19.13 | | C |
| ANISOU | 6169 | CD1 | LEU | B | 442 | 1654 | 3052 | 2563 | −191 | −599 | 98 | C |
| ATOM | 6170 | CD2 | LEU | B | 442 | −1.804 | 45.270 | 29.735 | 1.00 | 18.85 | | C |
| ANISOU | 6170 | CD2 | LEU | B | 442 | 1522 | 3082 | 2557 | −143 | −498 | 37 | C |
| ATOM | 6171 | N | THR | B | 443 | 1.724 | 41.367 | 30.961 | 1.00 | 22.36 | | N |
| ANISOU | 6171 | N | THR | B | 443 | 2029 | 3471 | 2995 | −295 | −443 | 124 | N |
| ATOM | 6172 | CA | THR | B | 443 | 2.131 | 40.400 | 31.983 | 1.00 | 29.64 | | C |
| ANISOU | 6172 | CA | THR | B | 443 | 2949 | 4416 | 3896 | −315 | −471 | 141 | C |
| ATOM | 6173 | C | THR | B | 443 | 3.178 | 41.009 | 32.950 | 1.00 | 38.21 | | C |
| ANISOU | 6173 | C | THR | B | 443 | 4015 | 5474 | 5028 | −283 | −522 | 99 | C |
| ATOM | 6174 | O | THR | B | 443 | 3.539 | 40.403 | 33.962 | 1.00 | 34.02 | | O |
| ANISOU | 6174 | O | THR | B | 443 | 3511 | 4951 | 4464 | −281 | −581 | 104 | O |
| ATOM | 6175 | CB | THR | B | 443 | 2.678 | 39.086 | 31.343 | 1.00 | 20.75 | | C |
| ANISOU | 6175 | CB | THR | B | 443 | 1863 | 3231 | 2792 | −344 | −460 | 184 | C |
| ATOM | 6176 | OG1 | THR | B | 443 | 3.732 | 39.373 | 30.418 | 1.00 | 20.01 | | O |
| ANISOU | 6176 | OG1 | THR | B | 443 | 1776 | 3038 | 2788 | −321 | −411 | 176 | O |
| ATOM | 6177 | CG2 | THR | B | 443 | 1.576 | 38.378 | 30.600 | 1.00 | 17.91 | | C |
| ANISOU | 6177 | CG2 | THR | B | 443 | 1539 | 2886 | 2378 | −382 | −457 | 215 | C |
| ATOM | 6178 | N | PHE | B | 444 | 3.637 | 42.225 | 32.654 | 1.00 | 37.80 | | N |
| ANISOU | 6178 | N | PHE | B | 444 | 3931 | 5374 | 5056 | −257 | −519 | 57 | N |
| ATOM | 6179 | CA | PHE | B | 444 | 4.427 | 42.985 | 33.621 | 1.00 | 26.87 | | C |
| ANISOU | 6179 | CA | PHE | B | 444 | 2526 | 3954 | 3729 | −231 | −604 | 1 | C |
| ATOM | 6180 | C | PHE | B | 444 | 3.551 | 44.005 | 34.360 | 1.00 | 29.53 | | C |
| ANISOU | 6180 | C | PHE | B | 444 | 2899 | 4350 | 3971 | −195 | −620 | −48 | C |
| ATOM | 6181 | O | PHE | B | 444 | 3.913 | 44.422 | 35.448 | 1.00 | 34.59 | | O |
| ANISOU | 6181 | O | PHE | B | 444 | 3579 | 4976 | 4587 | −165 | −711 | −98 | O |
| ATOM | 6182 | CB | PHE | B | 444 | 5.600 | 43.695 | 32.926 | 1.00 | 26.22 | | C |
| ANISOU | 6182 | CB | PHE | B | 444 | 2371 | 3752 | 3839 | −232 | −586 | −17 | C |
| ATOM | 6183 | CG | PHE | B | 444 | 6.778 | 44.000 | 33.838 | 1.00 | 27.28 | | C |
| ANISOU | 6183 | CG | PHE | B | 444 | 2448 | 3808 | 4111 | −223 | −718 | −66 | C |
| ATOM | 6184 | CD1 | PHE | B | 444 | 7.615 | 42.975 | 34.283 | 1.00 | 26.50 | | C |
| ANISOU | 6184 | CD1 | PHE | B | 444 | 2318 | 3671 | 4079 | −224 | −800 | −51 | C |
| ATOM | 6185 | CD2 | PHE | B | 444 | 7.065 | 45.305 | 34.219 | 1.00 | 27.59 | | C |
| ANISOU | 6185 | CD2 | PHE | B | 444 | 2463 | 3792 | 4229 | −210 | −784 | −132 | C |
| ATOM | 6186 | CE1 | PHE | B | 444 | 8.703 | 43.239 | 35.111 | 1.00 | 26.14 | | C |
| ANISOU | 6186 | CE1 | PHE | B | 444 | 2211 | 3534 | 4187 | −210 | −970 | −103 | C |
| ATOM | 6187 | CE2 | PHE | B | 444 | 8.148 | 45.594 | 35.041 | 1.00 | 26.09 | | C |
| ANISOU | 6187 | CE2 | PHE | B | 444 | 2217 | 3507 | 4190 | −205 | −949 | −187 | C |
| ATOM | 6188 | CZ | PHE | B | 444 | 8.978 | 44.555 | 35.491 | 1.00 | 31.12 | | C |
| ANISOU | 6188 | CZ | PHE | B | 444 | 2814 | 4105 | 4905 | −204 | −1055 | −174 | C |
| ATOM | 6189 | N | PHE | B | 445 | 2.413 | 44.407 | 33.778 | 1.00 | 21.91 | | N |
| ANISOU | 6189 | N | PHE | B | 445 | 1931 | 3437 | 2956 | −187 | −544 | −37 | N |
| ATOM | 6190 | CA | PHE | B | 445 | 1.482 | 45.330 | 34.449 | 1.00 | 21.22 | | C |
| ANISOU | 6190 | CA | PHE | B | 445 | 1865 | 3403 | 2796 | −139 | −533 | −82 | C |
| ATOM | 6191 | C | PHE | B | 445 | 0.625 | 44.613 | 35.487 | 1.00 | 28.93 | | C |
| ANISOU | 6191 | C | PHE | B | 445 | 2884 | 4465 | 3642 | −132 | −495 | −64 | C |
| ATOM | 6192 | O | PHE | B | 445 | 0.254 | 45.196 | 36.518 | 1.00 | 27.19 | | O |
| ANISOU | 6192 | O | PHE | B | 445 | 2727 | 4267 | 3336 | −79 | −483 | −108 | O |
| ATOM | 6193 | CB | PHE | B | 445 | 0.523 | 46.001 | 33.459 | 1.00 | 19.12 | | C |
| ANISOU | 6193 | CB | PHE | B | 445 | 1562 | 3148 | 2553 | −121 | −479 | −76 | C |
| ATOM | 6194 | CG | PHE | B | 445 | 1.143 | 47.076 | 32.601 | 1.00 | 30.94 | | C |
| ANISOU | 6194 | CG | PHE | B | 445 | 3062 | 4549 | 4144 | −107 | −486 | −96 | C |
| ATOM | 6195 | CD1 | PHE | B | 445 | 2.142 | 46.769 | 31.691 | 1.00 | 24.74 | | C |
| ANISOU | 6195 | CD1 | PHE | B | 445 | 2279 | 3679 | 3442 | −144 | −466 | −62 | C |
| ATOM | 6196 | CD2 | PHE | B | 445 | 0.677 | 48.392 | 32.659 | 1.00 | 19.46 | | C |
| ANISOU | 6196 | CD2 | PHE | B | 445 | 1616 | 3077 | 2699 | −52 | −489 | −144 | C |
| ATOM | 6197 | CE1 | PHE | B | 445 | 2.696 | 47.752 | 30.883 | 1.00 | 22.36 | | C |
| ANISOU | 6197 | CE1 | PHE | B | 445 | 1994 | 3271 | 3231 | −136 | −431 | −66 | C |
| ATOM | 6198 | CE2 | PHE | B | 445 | 1.219 | 49.374 | 31.850 | 1.00 | 19.56 | | C |
| ANISOU | 6198 | CE2 | PHE | B | 445 | 1649 | 2985 | 2799 | −45 | −483 | −150 | C |
| ATOM | 6199 | CZ | PHE | B | 445 | 2.226 | 49.059 | 30.959 | 1.00 | 26.57 | | C |
| ANISOU | 6199 | CZ | PHE | B | 445 | 2544 | 3784 | 3768 | −90 | −445 | −107 | C |
| ATOM | 6200 | N | LYS | B | 446 | 0.271 | 43.362 | 35.184 | 1.00 | 24.04 | | N |
| ANISOU | 6200 | N | LYS | B | 446 | 2246 | 3880 | 3009 | −183 | −458 | 4 | N |
| ATOM | 6201 | CA | LYS | B | 446 | −0.768 | 42.647 | 35.942 | 1.00 | 24.05 | | C |
| ANISOU | 6201 | CA | LYS | B | 446 | 2265 | 3952 | 2922 | −192 | −376 | 43 | C |
| ATOM | 6202 | C | LYS | B | 446 | −0.476 | 42.624 | 37.441 | 1.00 | 23.08 | | C |
| ANISOU | 6202 | C | LYS | B | 446 | 2276 | 3831 | 2664 | −150 | −380 | 23 | C |
| ATOM | 6203 | O | LYS | B | 446 | 0.641 | 42.362 | 37.853 | 1.00 | 25.39 | | O |
| ANISOU | 6203 | O | LYS | B | 446 | 2644 | 4069 | 2934 | −146 | −490 | 10 | O |
| ATOM | 6204 | CB | LYS | B | 446 | −0.947 | 41.214 | 35.396 | 1.00 | 20.88 | | C |
| ANISOU | 6204 | CB | LYS | B | 446 | 1836 | 3552 | 2544 | −267 | −363 | 119 | C |
| ATOM | 6205 | CG | LYS | B | 446 | −2.217 | 40.492 | 35.905 | 1.00 | 27.32 | | C |
| ANISOU | 6205 | CG | LYS | B | 446 | 2624 | 4424 | 3332 | −299 | −252 | 173 | C |
| ATOM | 6206 | CD | LYS | B | 446 | −2.880 | 39.612 | 34.816 | 1.00 | 26.00 | | C |
| ANISOU | 6206 | CD | LYS | B | 446 | 2364 | 4247 | 3267 | −374 | −261 | 222 | C |
| ATOM | 6207 | CE | LYS | B | 446 | −1.958 | 38.459 | 34.395 | 1.00 | 24.95 | | C |
| ANISOU | 6207 | CE | LYS | B | 446 | 2297 | 4058 | 3124 | −423 | −330 | 258 | C |
| ATOM | 6208 | NZ | LYS | B | 446 | −1.687 | 37.559 | 35.545 | 1.00 | 21.80 | | N |
| ANISOU | 6208 | NZ | LYS | B | 446 | 1990 | 3659 | 2634 | −439 | −293 | 305 | N |
| ATOM | 6209 | N | ASN | B | 447 | −1.498 | 42.924 | 38.234 | 1.00 | 27.51 | | N |
| ANISOU | 6209 | N | ASN | B | 447 | 2873 | 4439 | 3139 | −109 | −260 | 18 | N |
| ATOM | 6210 | CA | ASN | B | 447 | −1.404 | 43.029 | 39.696 | 1.00 | 25.03 | | C |
| ANISOU | 6210 | CA | ASN | B | 447 | 2748 | 4116 | 2648 | −47 | −234 | −5 | C |
| ATOM | 6211 | C | ASN | B | 447 | −0.320 | 43.991 | 40.179 | 1.00 | 27.85 | | C |
| ANISOU | 6211 | C | ASN | B | 447 | 3217 | 4403 | 2964 | 15 | −397 | −98 | C |
| ATOM | 6212 | O | ASN | B | 447 | 0.319 | 43.769 | 41.221 | 1.00 | 26.18 | | O |
| ANISOU | 6212 | O | ASN | B | 447 | 3191 | 4142 | 2613 | 52 | −489 | −118 | O |
| ATOM | 6213 | CB | ASN | B | 447 | −1.194 | 41.651 | 40.306 | 1.00 | 24.19 | | C |
| ANISOU | 6213 | CB | ASN | B | 447 | 2751 | 3998 | 2440 | −85 | −222 | 72 | C |
| ATOM | 6214 | CG | ASN | B | 447 | −2.267 | 40.693 | 39.907 | 1.00 | 31.21 | | C |
| ANISOU | 6214 | CG | ASN | B | 447 | 3531 | 4936 | 3393 | −157 | −66 | 163 | C |
| ATOM | 6215 | OD1 | ASN | B | 447 | −1.992 | 39.546 | 39.536 | 1.00 | 38.28 | | O |
| ANISOU | 6215 | OD1 | ASN | B | 447 | 4409 | 5814 | 4324 | −228 | −103 | 227 | O |
| ATOM | 6216 | ND2 | ASN | B | 447 | −3.506 | 41.165 | 39.919 | 1.00 | 24.96 | | N |
| ANISOU | 6216 | ND2 | ASN | B | 447 | 2645 | 4191 | 2648 | −141 | 100 | 165 | N |
| ATOM | 6217 | N | ARG | B | 448 | −0.105 | 45.054 | 39.407 | 1.00 | 26.25 | | N |
| ANISOU | 6217 | N | ARG | B | 448 | 2908 | 4176 | 2888 | 24 | −451 | −155 | N |
| ATOM | 6218 | CA | ARG | B | 448 | 0.709 | 46.172 | 39.874 | 1.00 | 29.98 | | C |
| ANISOU | 6218 | CA | ARG | B | 448 | 3466 | 4569 | 3355 | 79 | −590 | −252 | C |
| ATOM | 6219 | C | ARG | B | 448 | 0.034 | 47.490 | 39.534 | 1.00 | 29.22 | | C |
| ANISOU | 6219 | C | ARG | B | 448 | 3317 | 4477 | 3307 | 129 | −524 | −308 | C |
| ATOM | 6220 | O | ARG | B | 448 | −0.739 | 47.549 | 38.588 | 1.00 | 23.08 | | O |
| ANISOU | 6220 | O | ARG | B | 448 | 2398 | 3747 | 2625 | 108 | −426 | −269 | O |
| ATOM | 6221 | CB | ARG | B | 448 | 2.094 | 46.159 | 39.236 | 1.00 | 30.19 | | C |
| ANISOU | 6221 | CB | ARG | B | 448 | 3411 | 4513 | 3548 | 28 | −758 | −264 | C |
| ATOM | 6222 | CG | ARG | B | 448 | 2.958 | 44.994 | 39.577 | 1.00 | 34.18 | | C |
| ANISOU | 6222 | CG | ARG | B | 448 | 3956 | 4986 | 4044 | −3 | −862 | −224 | C |
| ATOM | 6223 | CD | ARG | B | 448 | 4.234 | 45.094 | 38.775 | 1.00 | 33.34 | | C |
| ANISOU | 6223 | CD | ARG | B | 448 | 3713 | 4790 | 4166 | −48 | −978 | −235 | C |
| ATOM | 6224 | NE | ARG | B | 448 | 5.338 | 44.471 | 39.485 | 1.00 | 34.56 | | N |
| ANISOU | 6224 | NE | ARG | B | 448 | 3921 | 4866 | 4344 | −41 | −1164 | −246 | N |
| ATOM | 6225 | CZ | ARG | B | 448 | 6.337 | 43.844 | 38.891 | 1.00 | 38.84 | | C |
| ANISOU | 6225 | CZ | ARG | B | 448 | 4338 | 5347 | 5074 | −81 | −1223 | −214 | C |
| ATOM | 6226 | NH1 | ARG | B | 448 | 6.368 | 43.771 | 37.570 | 1.00 | 35.21 | | N |
| ANISOU | 6226 | NH1 | ARG | B | 448 | 3724 | 4892 | 4760 | −131 | −1088 | −170 | N |
| ATOM | 6227 | NH2 | ARG | B | 448 | 7.310 | 43.307 | 39.617 | 1.00 | 44.70 | | N |
| ANISOU | 6227 | NH2 | ARG | B | 448 | 5121 | 6007 | 5856 | −61 | −1419 | −230 | N |
| ATOM | 6228 | N | GLN | B | 449 | 0.338 | 48.542 | 40.290 | 1.00 | 29.29 | | N |
| ANISOU | 6228 | N | GLN | B | 449 | 3454 | 4420 | 3255 | 200 | −602 | −403 | N |
| ATOM | 6229 | CA | GLN | B | 449 | 0.110 | 49.893 | 39.789 | 1.00 | 29.70 | | C |
| ANISOU | 6229 | CA | GLN | B | 449 | 3449 | 4434 | 3403 | 237 | −598 | −465 | C |
| ATOM | 6230 | C | GLN | B | 449 | 1.339 | 50.290 | 38.984 | 1.00 | 29.69 | | C |
| ANISOU | 6230 | C | GLN | B | 449 | 3356 | 4336 | 3589 | 175 | −750 | −480 | C |
| ATOM | 6231 | O | GLN | B | 449 | 2.466 | 50.249 | 39.480 | 1.00 | 31.53 | | O |
| ANISOU | 6231 | O | GLN | B | 449 | 3645 | 4484 | 3851 | 157 | −916 | −520 | O |
| ATOM | 6232 | CB | GLN | B | 449 | −0.166 | 50.898 | 40.920 | 1.00 | 31.06 | | C |
| ANISOU | 6232 | CB | GLN | B | 449 | 3810 | 4559 | 3431 | 346 | −603 | −567 | C |
| ATOM | 6233 | CG | GLN | B | 449 | −1.569 | 50.772 | 41.502 | 1.00 | 27.51 | | C |
| ANISOU | 6233 | CG | GLN | B | 449 | 3415 | 4193 | 2845 | 424 | −373 | −549 | C |
| ATOM | 6234 | CD | GLN | B | 449 | −1.927 | 51.872 | 42.477 | 1.00 | 37.69 | | C |
| ANISOU | 6234 | CD | GLN | B | 449 | 4899 | 5426 | 3996 | 551 | −336 | −654 | C |
| ATOM | 6235 | OE1 | GLN | B | 449 | −2.547 | 52.859 | 42.105 | 1.00 | 45.89 | | O |
| ANISOU | 6235 | OE1 | GLN | B | 449 | 5868 | 6454 | 5115 | 608 | −267 | −695 | O |
| ATOM | 6236 | NE2 | GLN | B | 449 | −1.552 | 51.699 | 43.736 | 1.00 | 36.34 | | N |
| ANISOU | 6236 | NE2 | GLN | B | 449 | 5000 | 5203 | 3604 | 608 | −388 | −702 | N |
| ATOM | 6237 | N | VAL | B | 450 | 1.123 | 50.611 | 37.717 | 1.00 | 28.84 | | N |
| ANISOU | 6237 | N | VAL | B | 450 | 3108 | 4229 | 3620 | 141 | −689 | −441 | N |
| ATOM | 6238 | CA | VAL | B | 450 | 2.189 | 51.120 | 36.876 | 1.00 | 24.28 | | C |
| ANISOU | 6238 | CA | VAL | B | 450 | 2454 | 3544 | 3229 | 88 | −768 | −445 | C |
| ATOM | 6239 | C | VAL | B | 450 | 1.917 | 52.596 | 36.664 | 1.00 | 31.51 | | C |
| ANISOU | 6239 | C | VAL | B | 450 | 3389 | 4390 | 4195 | 137 | −766 | −505 | C |
| ATOM | 6240 | O | VAL | B | 450 | 0.932 | 52.989 | 36.034 | 1.00 | 28.95 | | O |
| ANISOU | 6240 | O | VAL | B | 450 | 3034 | 4105 | 3862 | 174 | −668 | −482 | O |
| ATOM | 6241 | CB | VAL | B | 450 | 2.290 | 50.396 | 35.544 | 1.00 | 21.52 | | C |
| ANISOU | 6241 | CB | VAL | B | 450 | 1992 | 3212 | 2974 | 21 | −692 | −350 | C |
| ATOM | 6242 | CG1 | VAL | B | 450 | 3.361 | 51.027 | 34.688 | 1.00 | 21.53 | | C |
| ANISOU | 6242 | CG1 | VAL | B | 450 | 1934 | 3081 | 3165 | −23 | −715 | −347 | C |
| ATOM | 6243 | CG2 | VAL | B | 450 | 2.585 | 48.897 | 35.778 | 1.00 | 26.73 | | C |
| ANISOU | 6243 | CG2 | VAL | B | 450 | 2642 | 3927 | 3589 | −23 | −699 | −295 | C |
| ATOM | 6244 | N | ILE | B | 451 | 2.814 | 53.402 | 37.214 | 1.00 | 32.37 | | N |
| ANISOU | 6244 | N | ILE | B | 451 | 3549 | 4378 | 4374 | 139 | −900 | −585 | N |
| ATOM | 6245 | CA | ILE | B | 451 | 2.592 | 54.818 | 37.388 | 1.00 | 30.53 | | C |
| ANISOU | 6245 | CA | ILE | B | 451 | 3380 | 4060 | 4161 | 196 | −928 | −665 | C |
| ATOM | 6246 | C | ILE | B | 451 | 3.439 | 55.645 | 36.446 | 1.00 | 29.05 | | C |
| ANISOU | 6246 | C | ILE | B | 451 | 3110 | 3728 | 4199 | 135 | −956 | −656 | C |
| ATOM | 6247 | O | ILE | B | 451 | 4.663 | 55.650 | 36.562 | 1.00 | 33.16 | | O |
| ANISOU | 6247 | O | ILE | B | 451 | 3581 | 4138 | 4880 | 68 | −1069 | −675 | O |
| ATOM | 6248 | CB | ILE | B | 451 | 2.918 | 55.210 | 38.815 | 1.00 | 33.32 | | C |
| ANISOU | 6248 | CB | ILE | B | 451 | 3895 | 4353 | 4413 | 250 | −1076 | −779 | C |
| ATOM | 6249 | CG1 | ILE | B | 451 | 2.091 | 54.352 | 39.778 | 1.00 | 27.84 | | C |
| ANISOU | 6249 | CG1 | ILE | B | 451 | 3323 | 3785 | 3470 | 316 | −1005 | −773 | C |
| ATOM | 6250 | CG2 | ILE | B | 451 | 2.710 | 56.720 | 39.003 | 1.00 | 35.47 | | C |
| ANISOU | 6250 | CG2 | ILE | B | 451 | 4253 | 4516 | 4708 | 315 | −1113 | −874 | C |
| ATOM | 6251 | CD1 | ILE | B | 451 | 2.747 | 54.131 | 41.116 | 1.00 | 30.03 | | C |
| ANISOU | 6251 | CD1 | ILE | B | 451 | 3789 | 4002 | 3618 | 346 | −1179 | −850 | C |
| ATOM | 6252 | N | PHE | B | 452 | 2.784 | 56.349 | 35.530 | 1.00 | 31.02 | | N |
| ANISOU | 6252 | N | PHE | B | 452 | 3345 | 3965 | 4478 | 162 | −852 | −623 | N |
| ATOM | 6253 | CA | PHE | B | 452 | 3.468 | 57.209 | 34.561 | 1.00 | 25.13 | | C |
| ANISOU | 6253 | CA | PHE | B | 452 | 2557 | 3066 | 3925 | 111 | −836 | −598 | C |
| ATOM | 6254 | C | PHE | B | 452 | 3.499 | 58.649 | 35.054 | 1.00 | 35.90 | | C |
| ANISOU | 6254 | C | PHE | B | 452 | 4003 | 4300 | 5336 | 156 | −918 | −695 | C |
| ATOM | 6255 | O | PHE | B | 452 | 2.550 | 59.403 | 34.850 | 1.00 | 36.72 | | O |
| ANISOU | 6255 | O | PHE | B | 452 | 4171 | 4410 | 5371 | 238 | −866 | −708 | O |
| ATOM | 6256 | CB | PHE | B | 452 | 2.785 | 57.131 | 33.198 | 1.00 | 24.29 | | C |
| ANISOU | 6256 | CB | PHE | B | 452 | 2436 | 2992 | 3802 | 120 | −695 | −498 | C |
| ATOM | 6257 | CG | PHE | B | 452 | 2.785 | 55.759 | 32.616 | 1.00 | 23.96 | | C |
| ANISOU | 6257 | CG | PHE | B | 452 | 2337 | 3049 | 3719 | 75 | −626 | −409 | C |
| ATOM | 6258 | CD1 | PHE | B | 452 | 1.895 | 54.800 | 33.080 | 1.00 | 22.55 | | C |
| ANISOU | 6258 | CD1 | PHE | B | 452 | 2151 | 3031 | 3387 | 108 | −618 | −403 | C |
| ATOM | 6259 | CD2 | PHE | B | 452 | 3.696 | 55.414 | 31.622 | 1.00 | 23.79 | | C |
| ANISOU | 6259 | CD2 | PHE | B | 452 | 2275 | 2944 | 3821 | −1 | −551 | −333 | C |
| ATOM | 6260 | CE1 | PHE | B | 452 | 1.910 | 53.520 | 32.566 | 1.00 | 27.62 | | C |
| ANISOU | 6260 | CE1 | PHE | B | 452 | 2749 | 3748 | 3998 | 61 | −569 | −327 | C |
| ATOM | 6261 | CE2 | PHE | B | 452 | 3.710 | 54.132 | 31.099 | 1.00 | 26.30 | | C |
| ANISOU | 6261 | CE2 | PHE | B | 452 | 2564 | 3339 | 4089 | −33 | −489 | −261 | C |
| ATOM | 6262 | CZ | PHE | B | 452 | 2.818 | 53.184 | 31.568 | 1.00 | 23.18 | | C |
| ANISOU | 6262 | CZ | PHE | B | 452 | 2165 | 3102 | 3539 | −4 | −514 | −261 | C |
| ATOM | 6263 | N | ASP | B | 453 | 4.586 | 59.019 | 35.724 | 1.00 | 33.85 | | N |
| ANISOU | 6263 | N | ASP | B | 453 | 3742 | 3911 | 5210 | 106 | −1067 | −768 | N |
| ATOM | 6264 | CA | ASP | B | 453 | 4.747 | 60.366 | 36.276 | 1.00 | 30.54 | | C |
| ANISOU | 6264 | CA | ASP | B | 453 | 3415 | 3339 | 4852 | 138 | −1183 | −876 | C |
| ATOM | 6265 | C | ASP | B | 453 | 5.365 | 61.299 | 35.237 | 1.00 | 29.70 | | C |
| ANISOU | 6265 | C | ASP | B | 453 | 3244 | 3051 | 4991 | 66 | −1129 | −829 | C |
| ATOM | 6266 | O | ASP | B | 453 | 6.596 | 61.418 | 35.152 | 1.00 | 30.59 | | O |
| ANISOU | 6266 | O | ASP | B | 453 | 3254 | 3015 | 5354 | −38 | −1197 | −830 | O |
| ATOM | 6267 | CB | ASP | B | 453 | 5.612 | 60.311 | 37.535 | 1.00 | 30.52 | | C |
| ANISOU | 6267 | CB | ASP | B | 453 | 3459 | 3257 | 4880 | 120 | −1414 | −987 | C |
| ATOM | 6268 | CG | ASP | B | 453 | 5.614 | 61.616 | 38.325 | 1.00 | 35.84 | | C |
| ANISOU | 6268 | CG | ASP | B | 453 | 4285 | 3780 | 5554 | 175 | −1566 | −1125 | C |
| ATOM | 6269 | OD1 | ASP | B | 453 | 5.362 | 62.707 | 37.753 | 1.00 | 34.46 | | O |
| ANISOU | 6269 | OD1 | ASP | B | 453 | 4126 | 3503 | 5464 | 188 | −1504 | −1126 | O |
| ATOM | 6270 | OD2 | ASP | B | 453 | 5.886 | 61.530 | 39.543 | 1.00 | 38.10 | | O |
| ANISOU | 6270 | OD2 | ASP | B | 453 | 4701 | 4035 | 5741 | 213 | −1761 | −1234 | O |
| ATOM | 6271 | N | ILE | B | 454 | 4.506 | 61.942 | 34.449 | 1.00 | 29.41 | | N |
| ANISOU | 6271 | N | ILE | B | 454 | 3265 | 3014 | 4896 | 125 | −1004 | −784 | N |
| ATOM | 6272 | CA | ILE | B | 454 | 4.943 | 62.796 | 33.346 | 1.00 | 30.00 | | C |
| ANISOU | 6272 | CA | ILE | B | 454 | 3326 | 2915 | 5158 | 70 | −913 | −715 | C |
| ATOM | 6273 | C | ILE | B | 454 | 5.703 | 64.021 | 33.838 | 1.00 | 39.19 | | C |
| ANISOU | 6273 | C | ILE | B | 454 | 4514 | 3855 | 6521 | 30 | −1041 | −806 | C |
| ATOM | 6274 | O | ILE | B | 454 | 6.649 | 64.472 | 33.202 | 1.00 | 43.00 | | O |
| ANISOU | 6274 | O | ILE | B | 454 | 4923 | 4155 | 7259 | −75 | −993 | −754 | O |
| ATOM | 6275 | CB | ILE | B | 454 | 3.742 | 63.267 | 32.497 | 1.00 | 29.57 | | C |
| ANISOU | 6275 | CB | ILE | B | 454 | 3370 | 2898 | 4968 | 169 | −798 | −657 | C |
| ATOM | 6276 | CG1 | ILE | B | 454 | 3.106 | 62.093 | 31.766 | 1.00 | 37.68 | | C |
| ANISOU | 6276 | CG1 | ILE | B | 454 | 4364 | 4100 | 5852 | 187 | −689 | −556 | C |
| ATOM | 6277 | CG2 | ILE | B | 454 | 4.164 | 64.366 | 31.520 | 1.00 | 34.45 | | C |
| ANISOU | 6277 | CG2 | ILE | B | 454 | 4040 | 3299 | 5750 | 131 | −722 | −597 | C |
| ATOM | 6278 | CD1 | ILE | B | 454 | 1.773 | 62.436 | 31.179 | 1.00 | 48.36 | | C |
| ANISOU | 6278 | CD1 | ILE | B | 454 | 5800 | 5507 | 7068 | 304 | −647 | −525 | C |
| ATOM | 6279 | N | GLN | B | 455 | 5.285 | 64.546 | 34.984 | 1.00 | 38.91 | | N |
| ANISOU | 6279 | N | GLN | B | 455 | 4591 | 3819 | 6373 | 113 | −1195 | −942 | N |
| ATOM | 6280 | CA | GLN | B | 455 | 5.884 | 65.741 | 35.555 | 1.00 | 34.70 | | C |
| ANISOU | 6280 | CA | GLN | B | 455 | 4119 | 3065 | 6003 | 89 | −1356 | −1052 | C |
| ATOM | 6281 | C | GLN | B | 455 | 7.360 | 65.500 | 35.921 | 1.00 | 44.25 | | C |
| ANISOU | 6281 | C | GLN | B | 455 | 5189 | 4136 | 7489 | −51 | −1511 | −1082 | C |
| ATOM | 6282 | O | GLN | B | 455 | 8.210 | 66.350 | 35.666 | 1.00 | 40.92 | | O |
| ANISOU | 6282 | O | GLN | B | 455 | 4705 | 3483 | 7358 | −146 | −1558 | −1092 | O |
| ATOM | 6283 | CB | GLN | B | 455 | 5.074 | 66.179 | 36.781 | 1.00 | 37.29 | | C |
| ANISOU | 6283 | CB | GLN | B | 455 | 4636 | 3434 | 6100 | 230 | −1483 | −1200 | C |
| ATOM | 6284 | CG | GLN | B | 455 | 5.763 | 67.207 | 37.678 | 1.00 | 42.69 | | C |
| ANISOU | 6284 | CG | GLN | B | 455 | 5420 | 3891 | 6909 | 213 | −1719 | −1351 | C |
| ATOM | 6285 | CD | GLN | B | 455 | 5.787 | 68.592 | 37.074 | 1.00 | 49.52 | | C |
| ANISOU | 6285 | CD | GLN | B | 455 | 6329 | 4544 | 7942 | 201 | −1691 | −1351 | C |
| ATOM | 6286 | OE1 | GLN | B | 455 | 4.954 | 68.925 | 36.223 | 1.00 | 51.80 | | O |
| ANISOU | 6286 | OE1 | GLN | B | 455 | 6646 | 4874 | 8162 | 267 | −1509 | −1268 | O |
| ATOM | 6287 | NE2 | GLN | B | 455 | 6.745 | 69.412 | 37.506 | 1.00 | 48.95 | | N |
| ANISOU | 6287 | NE2 | GLN | B | 455 | 6268 | 4224 | 8107 | 118 | −1890 | −1445 | N |
| ATOM | 6288 | N | LYS | B | 456 | 7.673 | 64.329 | 36.480 | 1.00 | 39.12 | | N |
| ANISOU | 6288 | N | LYS | B | 456 | 4473 | 3613 | 6776 | −67 | −1588 | −1091 | N |
| ATOM | 6289 | CA | LYS | B | 456 | 9.048 | 64.047 | 36.896 | 1.00 | 36.67 | | C |
| ANISOU | 6289 | CA | LYS | B | 456 | 4015 | 3170 | 6748 | −183 | −1774 | −1128 | C |
| ATOM | 6290 | C | LYS | B | 456 | 9.796 | 63.074 | 35.963 | 1.00 | 43.22 | | C |
| ANISOU | 6290 | C | LYS | B | 456 | 4615 | 4029 | 7778 | −288 | −1613 | −989 | C |
| ATOM | 6291 | O | LYS | B | 456 | 10.887 | 62.593 | 36.294 | 1.00 | 43.87 | | O |
| ANISOU | 6291 | O | LYS | B | 456 | 4537 | 4030 | 8100 | −371 | −1752 | −1008 | O |
| ATOM | 6292 | CB | LYS | B | 456 | 9.062 | 63.518 | 38.330 | 1.00 | 37.08 | | C |
| ANISOU | 6292 | CB | LYS | B | 456 | 4185 | 3287 | 6619 | −118 | −2035 | −1256 | C |
| ATOM | 6293 | CG | LYS | B | 456 | 8.851 | 64.596 | 39.390 | 1.00 | 45.45 | | C |
| ANISOU | 6293 | CG | LYS | B | 456 | 5469 | 4215 | 7585 | −42 | −2260 | −1425 | C |
| ATOM | 6294 | CD | LYS | B | 456 | 9.012 | 64.036 | 40.796 | 1.00 | 50.89 | | C |
| ANISOU | 6294 | CD | LYS | B | 456 | 6320 | 4934 | 8084 | 22 | −2531 | −1547 | C |
| ATOM | 6295 | CE | LYS | B | 456 | 8.983 | 65.123 | 41.856 | 1.00 | 56.78 | | C |
| ANISOU | 6295 | CE | LYS | B | 456 | 7320 | 5503 | 8750 | 95 | −2787 | −1729 | C |
| ATOM | 6296 | NZ | LYS | B | 456 | 7.708 | 65.902 | 41.844 | 1.00 | 64.98 | | N |
| ANISOU | 6296 | NZ | LYS | B | 456 | 8561 | 6600 | 9530 | 229 | −2605 | −1757 | N |
| ATOM | 6297 | N | ASN | B | 457 | 9.210 | 62.809 | 34.797 | 1.00 | 37.34 | | N |
| ANISOU | 6297 | N | ASN | B | 457 | 3866 | 3381 | 6938 | −274 | −1332 | −854 | N |
| ATOM | 6298 | CA | ASN | B | 457 | 9.831 | 61.981 | 33.767 | 1.00 | 39.20 | | C |
| ANISOU | 6298 | CA | ASN | B | 457 | 3937 | 3627 | 7331 | −356 | −1132 | −718 | C |
| ATOM | 6299 | C | ASN | B | 457 | 10.222 | 60.613 | 34.284 | 1.00 | 39.74 | | C |
| ANISOU | 6299 | C | ASN | B | 457 | 3907 | 3823 | 7371 | −365 | −1217 | −721 | C |
| ATOM | 6300 | O | ASN | B | 457 | 11.310 | 60.117 | 34.002 | 1.00 | 41.10 | | O |
| ANISOU | 6300 | O | ASN | B | 457 | 3885 | 3908 | 7824 | −454 | −1191 | −676 | O |
| ATOM | 6301 | CB | ASN | B | 457 | 11.067 | 62.673 | 33.193 | 1.00 | 46.32 | | C |
| ANISOU | 6301 | CB | ASN | B | 457 | 4675 | 4265 | 8661 | −486 | −1069 | −678 | C |
| ATOM | 6302 | CG | ASN | B | 457 | 10.731 | 63.975 | 32.487 | 1.00 | 65.74 | | C |
| ANISOU | 6302 | CG | ASN | B | 457 | 7245 | 6575 | 11157 | −487 | −938 | −642 | C |
| ATOM | 6303 | OD1 | ASN | B | 457 | 10.112 | 63.976 | 31.420 | 1.00 | 70.14 | | O |
| ANISOU | 6303 | OD1 | ASN | B | 457 | 7904 | 7181 | 11565 | −448 | −700 | −529 | O |
| ATOM | 6304 | ND2 | ASN | B | 457 | 11.128 | 65.099 | 33.090 | 1.00 | 70.84 | | N |
| ANISOU | 6304 | ND2 | ASN | B | 457 | 7895 | 7024 | 11996 | −525 | −1117 | −743 | N |
| ATOM | 6305 | N | ARG | B | 458 | 9.333 | 59.991 | 35.036 | 1.00 | 32.69 | | N |
| ANISOU | 6305 | N | ARG | B | 458 | 3143 | 3125 | 6153 | −268 | −1301 | −768 | N |
| ATOM | 6306 | CA | ARG | B | 458 | 9.653 | 58.689 | 35.560 | 1.00 | 31.09 | | C |
| ANISOU | 6306 | CA | ARG | B | 458 | 2880 | 3034 | 5899 | −270 | −1386 | −766 | C |
| ATOM | 6307 | C | ARG | B | 458 | 8.446 | 57.764 | 35.572 | 1.00 | 29.65 | | C |
| ANISOU | 6307 | C | ARG | B | 458 | 2814 | 3093 | 5360 | −184 | −1280 | −722 | C |
| ATOM | 6308 | O | ARG | B | 458 | 7.296 | 58.205 | 35.492 | 1.00 | 30.89 | | O |
| ANISOU | 6308 | O | ARG | B | 458 | 3102 | 3333 | 5300 | −106 | −1201 | −728 | O |
| ATOM | 6309 | CB | ARG | B | 458 | 10.216 | 58.833 | 36.959 | 1.00 | 32.72 | | C |
| ANISOU | 6309 | CB | ARG | B | 458 | 3124 | 3161 | 6149 | −261 | −1712 | −904 | C |
| ATOM | 6310 | CG | ARG | B | 458 | 9.157 | 59.231 | 37.914 | 1.00 | 32.71 | | C |
| ANISOU | 6310 | CG | ARG | B | 458 | 3372 | 3245 | 5810 | −144 | −1806 | −1000 | C |
| ATOM | 6311 | CD | ARG | B | 458 | 9.704 | 59.598 | 39.246 | 1.00 | 41.56 | | C |
| ANISOU | 6311 | CD | ARG | B | 458 | 4602 | 4244 | 6947 | −122 | −2138 | −1149 | C |
| ATOM | 6312 | NE | ARG | B | 458 | 8.608 | 60.100 | 40.059 | 1.00 | 41.45 | | N |
| ANISOU | 6312 | NE | ARG | B | 458 | 4862 | 4297 | 6591 | 6 | −2161 | −1238 | N |
| ATOM | 6313 | CZ | ARG | B | 458 | 8.692 | 60.337 | 41.359 | 1.00 | 43.76 | | C |
| ANISOU | 6313 | CZ | ARG | B | 458 | 5368 | 4521 | 6736 | 75 | −2418 | −1374 | C |
| ATOM | 6314 | NH1 | ARG | B | 458 | 9.833 | 60.119 | 42.007 | 1.00 | 38.44 | | N |
| ANISOU | 6314 | NH1 | ARG | B | 458 | 4664 | 3715 | 6226 | 33 | −2695 | −1425 | N |
| ATOM | 6315 | NH2 | ARG | B | 458 | 7.626 | 60.784 | 42.006 | 1.00 | 41.47 | | N |
| ANISOU | 6315 | NH2 | ARG | B | 458 | 5335 | 4292 | 6128 | 205 | −2370 | −1444 | N |
| ATOM | 6316 | N | ILE | B | 459 | 8.721 | 56.472 | 35.689 | 1.00 | 30.56 | | N |
| ANISOU | 6316 | N | ILE | B | 459 | 2864 | 3304 | 5443 | −199 | −1285 | −679 | N |
| ATOM | 6317 | CA | ILE | B | 459 | 7.675 | 55.470 | 35.789 | 1.00 | 30.45 | | C |
| ANISOU | 6317 | CA | ILE | B | 459 | 2941 | 3500 | 5129 | −135 | −1202 | −637 | C |
| ATOM | 6318 | C | ILE | B | 459 | 7.839 | 54.694 | 37.091 | 1.00 | 32.94 | | C |
| ANISOU | 6318 | C | ILE | B | 459 | 3325 | 3872 | 5321 | −102 | −1395 | −699 | C |
| ATOM | 6319 | O | ILE | B | 459 | 8.954 | 54.346 | 37.457 | 1.00 | 32.10 | | O |
| ANISOU | 6319 | O | ILE | B | 459 | 3127 | 3670 | 5400 | −148 | −1553 | −722 | O |
| ATOM | 6320 | CB | ILE | B | 459 | 7.711 | 54.530 | 34.579 | 1.00 | 25.67 | | C |
| ANISOU | 6320 | CB | ILE | B | 459 | 2240 | 2955 | 4557 | −176 | −999 | −510 | C |
| ATOM | 6321 | CG1 | ILE | B | 459 | 7.353 | 55.331 | 33.321 | 1.00 | 28.34 | | C |
| ANISOU | 6321 | CG1 | ILE | B | 459 | 2594 | 3236 | 4936 | −182 | −812 | −447 | C |
| ATOM | 6322 | CG2 | ILE | B | 459 | 6.784 | 53.350 | 34.776 | 1.00 | 24.36 | | C |
| ANISOU | 6322 | CG2 | ILE | B | 459 | 2142 | 2981 | 4131 | −131 | −953 | −472 | C |
| ATOM | 6323 | CD1 | ILE | B | 459 | 7.663 | 54.611 | 32.025 | 1.00 | 28.03 | | C |
| ANISOU | 6323 | CD1 | ILE | B | 459 | 2500 | 3188 | 4963 | −224 | −613 | −330 | C |
| ATOM | 6324 | N | GLY | B | 460 | 6.729 | 54.458 | 37.797 | 1.00 | 30.75 | | N |
| ANISOU | 6324 | N | GLY | B | 460 | 3213 | 3730 | 4740 | −17 | −1380 | −724 | N |
| ATOM | 6325 | CA | GLY | B | 460 | 6.750 | 53.774 | 39.078 | 1.00 | 27.72 | | C |
| ANISOU | 6325 | CA | GLY | B | 460 | 2965 | 3391 | 4178 | 31 | −1535 | −775 | C |
| ATOM | 6326 | C | GLY | B | 460 | 6.085 | 52.402 | 39.051 | 1.00 | 34.11 | | C |
| ANISOU | 6326 | C | GLY | B | 460 | 3793 | 4367 | 4799 | 44 | −1407 | −687 | C |
| ATOM | 6327 | O | GLY | B | 460 | 5.186 | 52.159 | 38.249 | 1.00 | 26.67 | | O |
| ANISOU | 6327 | O | GLY | B | 460 | 2805 | 3533 | 3794 | 44 | −1204 | −612 | O |
| ATOM | 6328 | N | PHE | B | 461 | 6.536 | 51.503 | 39.921 | 1.00 | 30.92 | | N |
| ANISOU | 6328 | N | PHE | B | 461 | 3464 | 3968 | 4317 | 55 | −1547 | −696 | N |
| ATOM | 6329 | CA | PHE | B | 461 | 5.947 | 50.163 | 40.023 | 1.00 | 30.73 | | C |
| ANISOU | 6329 | CA | PHE | B | 461 | 3480 | 4082 | 4115 | 63 | −1438 | −612 | C |
| ATOM | 6330 | C | PHE | B | 461 | 5.697 | 49.826 | 41.484 | 1.00 | 28.60 | | C |
| ANISOU | 6330 | C | PHE | B | 461 | 3463 | 3825 | 3581 | 142 | −1549 | −660 | C |
| ATOM | 6331 | O | PHE | B | 461 | 6.537 | 50.109 | 42.331 | 1.00 | 34.85 | | O |
| ANISOU | 6331 | O | PHE | B | 461 | 4359 | 4494 | 4387 | 168 | −1800 | −744 | O |
| ATOM | 6332 | CB | PHE | B | 461 | 6.862 | 49.088 | 39.394 | 1.00 | 25.68 | | C |
| ANISOU | 6332 | CB | PHE | B | 461 | 2677 | 3423 | 3657 | −9 | −1460 | −536 | C |
| ATOM | 6333 | CG | PHE | B | 461 | 7.173 | 49.327 | 37.943 | 1.00 | 34.16 | | C |
| ANISOU | 6333 | CG | PHE | B | 461 | 3548 | 4466 | 4964 | −76 | −1318 | −480 | C |
| ATOM | 6334 | CD1 | PHE | B | 461 | 6.321 | 48.871 | 36.952 | 1.00 | 27.78 | | C |
| ANISOU | 6334 | CD1 | PHE | B | 461 | 2703 | 3764 | 4088 | −92 | −1102 | −394 | C |
| ATOM | 6335 | CD2 | PHE | B | 461 | 8.317 | 50.024 | 37.566 | 1.00 | 39.26 | | C |
| ANISOU | 6335 | CD2 | PHE | B | 461 | 4056 | 4958 | 5905 | −123 | −1400 | −512 | C |
| ATOM | 6336 | CE1 | PHE | B | 461 | 6.598 | 49.099 | 35.606 | 1.00 | 24.09 | | C |
| ANISOU | 6336 | CE1 | PHE | B | 461 | 2114 | 3249 | 3789 | −139 | −970 | −341 | C |
| ATOM | 6337 | CE2 | PHE | B | 461 | 8.600 | 50.268 | 36.220 | 1.00 | 32.46 | | C |
| ANISOU | 6337 | CE2 | PHE | B | 461 | 3046 | 4050 | 5237 | −178 | −1224 | −449 | C |
| ATOM | 6338 | CZ | PHE | B | 461 | 7.737 | 49.804 | 35.240 | 1.00 | 27.18 | | C |
| ANISOU | 6338 | CZ | PHE | B | 461 | 2394 | 3488 | 4446 | −178 | −1009 | −364 | C |
| ATOM | 6339 | N | VAL | B | 462 | 4.554 | 49.217 | 41.779 | 1.00 | 27.31 | | N |
| ANISOU | 6339 | N | VAL | B | 462 | 3406 | 3789 | 3182 | 182 | −1366 | −607 | N |
| ATOM | 6340 | CA | VAL | B | 462 | 4.274 | 48.748 | 43.137 | 1.00 | 33.45 | | C |
| ANISOU | 6340 | CA | VAL | B | 462 | 4458 | 4572 | 3678 | 260 | −1414 | −628 | C |
| ATOM | 6341 | C | VAL | B | 462 | 3.193 | 47.666 | 43.077 | 1.00 | 31.42 | | C |
| ANISOU | 6341 | C | VAL | B | 462 | 4215 | 4454 | 3270 | 254 | −1166 | −517 | C |
| ATOM | 6342 | O | VAL | B | 462 | 2.280 | 47.744 | 42.264 | 1.00 | 34.96 | | O |
| ANISOU | 6342 | O | VAL | B | 462 | 4513 | 4995 | 3776 | 228 | −955 | −467 | O |
| ATOM | 6343 | CB | VAL | B | 462 | 3.867 | 49.931 | 44.066 | 1.00 | 30.52 | | C |
| ANISOU | 6343 | CB | VAL | B | 462 | 4318 | 4142 | 3135 | 363 | −1447 | −743 | C |
| ATOM | 6344 | CG1 | VAL | B | 462 | 2.541 | 50.541 | 43.635 | 1.00 | 29.88 | | C |
| ANISOU | 6344 | CG1 | VAL | B | 462 | 4183 | 4158 | 3014 | 397 | −1169 | −729 | C |
| ATOM | 6345 | CG2 | VAL | B | 462 | 3.863 | 49.531 | 45.533 | 1.00 | 32.65 | | C |
| ANISOU | 6345 | CG2 | VAL | B | 462 | 4940 | 4367 | 3098 | 456 | −1543 | −780 | C |
| ATOM | 6346 | N | ASP | B | 463 | 3.334 | 46.618 | 43.883 | 1.00 | 31.33 | | N |
| ANISOU | 6346 | N | ASP | B | 463 | 4372 | 4442 | 3092 | 271 | −1208 | −474 | N |
| ATOM | 6347 | CA | ASP | B | 463 | 2.336 | 45.546 | 43.904 | 1.00 | 31.65 | | C |
| ANISOU | 6347 | CA | ASP | B | 463 | 4430 | 4589 | 3006 | 254 | −970 | −363 | C |
| ATOM | 6348 | C | ASP | B | 463 | 1.004 | 46.072 | 44.405 | 1.00 | 33.07 | | C |
| ANISOU | 6348 | C | ASP | B | 463 | 4720 | 4829 | 3017 | 325 | −723 | −373 | C |
| ATOM | 6349 | O | ASP | B | 463 | 0.952 | 46.850 | 45.350 | 1.00 | 37.25 | | O |
| ANISOU | 6349 | O | ASP | B | 463 | 5482 | 5297 | 3373 | 423 | −758 | −458 | O |
| ATOM | 6350 | CB | ASP | B | 463 | 2.799 | 44.374 | 44.772 | 1.00 | 44.20 | | C |
| ANISOU | 6350 | CB | ASP | B | 463 | 6223 | 6138 | 4432 | 268 | −1069 | −313 | C |
| ATOM | 6351 | CG | ASP | B | 463 | 4.067 | 43.723 | 44.245 | 1.00 | 51.71 | | C |
| ANISOU | 6351 | CG | ASP | B | 463 | 7033 | 7030 | 5587 | 207 | −1293 | −295 | C |
| ATOM | 6352 | OD1 | ASP | B | 463 | 4.283 | 43.737 | 43.014 | 1.00 | 54.27 | | O |
| ANISOU | 6352 | OD1 | ASP | B | 463 | 7080 | 7383 | 6159 | 130 | −1254 | −271 | O |
| ATOM | 6353 | OD2 | ASP | B | 463 | 4.842 | 43.188 | 45.064 | 1.00 | 59.37 | | O |
| ANISOU | 6353 | OD2 | ASP | B | 463 | 8182 | 7910 | 6465 | 245 | −1504 | −303 | O |
| ATOM | 6354 | N | ALA | B | 464 | −0.079 | 45.675 | 43.756 | 1.00 | 33.03 | | N |
| ANISOU | 6354 | N | ALA | B | 464 | 4544 | 4927 | 3079 | 282 | −476 | −291 | N |
| ATOM | 6355 | CA | ALA | B | 464 | −1.374 | 46.227 | 44.114 | 1.00 | 37.77 | | C |
| ANISOU | 6355 | CA | ALA | B | 464 | 5179 | 5576 | 3595 | 350 | −223 | −299 | C |
| ATOM | 6356 | C | ALA | B | 464 | −2.525 | 45.252 | 43.928 | 1.00 | 36.15 | | C |
| ANISOU | 6356 | C | ALA | B | 464 | 4864 | 5458 | 3414 | 302 | 42 | −182 | C |
| ATOM | 6357 | O | ALA | B | 464 | −2.492 | 44.399 | 43.043 | 1.00 | 30.38 | | O |
| ANISOU | 6357 | O | ALA | B | 464 | 3942 | 4767 | 2835 | 200 | 25 | −106 | O |
| ATOM | 6358 | CB | ALA | B | 464 | −1.642 | 47.494 | 43.296 | 1.00 | 39.95 | | C |
| ANISOU | 6358 | CB | ALA | B | 464 | 5276 | 5859 | 4045 | 367 | −226 | −368 | C |
| ATOM | 6359 | N | ASN | B | 465 | −3.552 | 45.417 | 44.756 | 1.00 | 39.23 | | N |
| ANISOU | 6359 | N | ASN | B | 465 | 5374 | 5861 | 3670 | 379 | 295 | −173 | N |
| ATOM | 6360 | CA | ASN | B | 465 | −4.865 | 44.829 | 44.505 | 1.00 | 37.17 | | C |
| ANISOU | 6360 | CA | ASN | B | 465 | 4935 | 5670 | 3517 | 339 | 583 | −77 | C |
| ATOM | 6361 | C | ASN | B | 465 | −5.649 | 45.760 | 43.593 | 1.00 | 41.38 | | C |
| ANISOU | 6361 | C | ASN | B | 465 | 5192 | 6247 | 4282 | 352 | 640 | −116 | C |
| ATOM | 6362 | O | ASN | B | 465 | −6.288 | 46.713 | 44.053 | 1.00 | 46.25 | | O |
| ANISOU | 6362 | O | ASN | B | 465 | 5853 | 6853 | 4865 | 460 | 783 | −176 | O |
| ATOM | 6363 | CB | ASN | B | 465 | −5.617 | 44.598 | 45.814 | 1.00 | 34.99 | | C |
| ANISOU | 6363 | CB | ASN | B | 465 | 4903 | 5370 | 3021 | 421 | 873 | −40 | C |
| ATOM | 6364 | CG | ASN | B | 465 | −4.848 | 43.730 | 46.768 | 1.00 | 39.43 | | C |
| ANISOU | 6364 | CG | ASN | B | 465 | 5797 | 5869 | 3317 | 427 | 798 | 1 | C |
| ATOM | 6365 | OD1 | ASN | B | 465 | −4.520 | 44.144 | 47.877 | 1.00 | 48.81 | | O |
| ANISOU | 6365 | OD1 | ASN | B | 465 | 7339 | 6980 | 4225 | 541 | 783 | −57 | O |
| ATOM | 6366 | ND2 | ASN | B | 465 | −4.554 | 42.508 | 46.344 | 1.00 | 40.29 | | N |
| ANISOU | 6366 | ND2 | ASN | B | 465 | 5817 | 5991 | 3499 | 313 | 733 | 98 | N |
| ATOM | 6367 | N | CYS | B | 466 | −5.535 | 45.517 | 42.294 | 1.00 | 38.24 | | N |
| ANISOU | 6367 | N | CYS | B | 466 | 4541 | 5883 | 4106 | 256 | 510 | −89 | N |
| ATOM | 6368 | CA | CYS | B | 466 | −6.208 | 46.321 | 41.292 | 1.00 | 32.24 | | C |
| ANISOU | 6368 | CA | CYS | B | 466 | 3537 | 5148 | 3563 | 267 | 510 | −119 | C |
| ATOM | 6369 | C | CYS | B | 466 | −7.675 | 45.948 | 41.270 | 1.00 | 37.16 | | C |
| ANISOU | 6369 | C | CYS | B | 466 | 3971 | 5814 | 4333 | 262 | 756 | −54 | C |
| ATOM | 6370 | O | CYS | B | 466 | −8.025 | 44.813 | 41.562 | 1.00 | 39.64 | | O |
| ANISOU | 6370 | O | CYS | B | 466 | 4272 | 6143 | 4647 | 193 | 880 | 37 | O |
| ATOM | 6371 | CB | CYS | B | 466 | −5.576 | 46.106 | 39.915 | 1.00 | 26.71 | | C |
| ANISOU | 6371 | CB | CYS | B | 466 | 2687 | 4448 | 3015 | 175 | 292 | −105 | C |
| ATOM | 6372 | SG | CYS | B | 466 | −3.816 | 46.524 | 39.833 | 1.00 | 42.75 | | S |
| ANISOU | 6372 | SG | CYS | B | 466 | 4871 | 6409 | 4964 | 169 | 31 | −171 | S |
| ATOM | 6373 | N | PRO | B | 467 | −8.543 | 46.902 | 40.918 | 1.00 | 41.50 | | N |
| ANISOU | 6373 | N | PRO | B | 467 | 4359 | 6370 | 5038 | 333 | 824 | −97 | N |
| ATOM | 6374 | CA | PRO | B | 467 | −9.969 | 46.575 | 40.751 | 1.00 | 36.12 | | C |
| ANISOU | 6374 | CA | PRO | B | 467 | 3425 | 5715 | 4583 | 323 | 1029 | −38 | C |
| ATOM | 6375 | C | PRO | B | 467 | −10.191 | 45.596 | 39.600 | 1.00 | 32.00 | | C |
| ANISOU | 6375 | C | PRO | B | 467 | 2679 | 5211 | 4270 | 187 | 898 | 36 | C |
| ATOM | 6376 | O | PRO | B | 467 | −9.367 | 45.565 | 38.689 | 1.00 | 33.64 | | O |
| ANISOU | 6376 | O | PRO | B | 467 | 2905 | 5410 | 4468 | 136 | 649 | 20 | O |
| ATOM | 6377 | CB | PRO | B | 467 | −10.616 | 47.937 | 40.444 | 1.00 | 35.38 | | C |
| ANISOU | 6377 | CB | PRO | B | 467 | 3209 | 5607 | 4627 | 442 | 1042 | −117 | C |
| ATOM | 6378 | CG | PRO | B | 467 | −9.623 | 48.975 | 40.951 | 1.00 | 34.95 | | C |
| ANISOU | 6378 | CG | PRO | B | 467 | 3427 | 5513 | 4340 | 533 | 941 | −219 | C |
| ATOM | 6379 | CD | PRO | B | 467 | −8.263 | 48.342 | 40.745 | 1.00 | 37.56 | | C |
| ANISOU | 6379 | CD | PRO | B | 467 | 3906 | 5837 | 4529 | 433 | 719 | −203 | C |
| ATOM | 6380 | N | SER | B | 468 | −11.292 | 44.844 | 39.638 | 1.00 | 35.66 | | N |
| ANISOU | 6380 | N | SER | B | 468 | 2940 | 5681 | 4930 | 134 | 1069 | 112 | N |
| ATOM | 6381 | CA | SER | B | 468 | −11.664 | 43.889 | 38.584 | 1.00 | 37.37 | | C |
| ANISOU | 6381 | CA | SER | B | 468 | 2939 | 5892 | 5369 | 5 | 935 | 174 | C |
| ATOM | 6382 | C | SER | B | 468 | −12.985 | 44.247 | 37.912 | 1.00 | 35.06 | | C |
| ANISOU | 6382 | C | SER | B | 468 | 2316 | 5584 | 5422 | 23 | 941 | 170 | C |
| ATOM | 6383 | O | SER | B | 468 | −13.914 | 44.679 | 38.573 | 1.00 | 38.32 | | O |
| ANISOU | 6383 | O | SER | B | 468 | 2607 | 5993 | 5958 | 98 | 1185 | 170 | O |
| ATOM | 6384 | CB | SER | B | 468 | −11.796 | 42.466 | 39.153 | 1.00 | 36.02 | | C |
| ANISOU | 6384 | CB | SER | B | 468 | 2793 | 5712 | 5179 | −106 | 1087 | 278 | C |
| ATOM | 6385 | OG | SER | B | 468 | −10.530 | 41.948 | 39.467 | 1.00 | 44.90 | | O |
| ANISOU | 6385 | OG | SER | B | 468 | 4191 | 6837 | 6030 | −138 | 990 | 287 | O |
| ATOM | 6386 | N | HIS | B | 469 | −13.067 | 44.050 | 36.601 | 1.00 | 34.19 | | N |
| ANISOU | 6386 | N | HIS | B | 469 | 2069 | 5449 | 5471 | −38 | 669 | 167 | N |
| ATOM | 6387 | CA | HIS | B | 469 | −14.330 | 44.188 | 35.883 | 1.00 | 38.03 | | C |
| ANISOU | 6387 | CA | HIS | B | 469 | 2234 | 5898 | 6316 | −36 | 605 | 168 | C |
| ATOM | 6388 | C | HIS | B | 469 | −14.381 | 43.125 | 34.791 | 1.00 | 48.30 | | C |
| ANISOU | 6388 | C | HIS | B | 469 | 3451 | 7157 | 7746 | −171 | 358 | 208 | C |
| ATOM | 6389 | O | HIS | B | 469 | −13.428 | 42.985 | 34.024 | 1.00 | 49.93 | | O |
| ANISOU | 6389 | O | HIS | B | 469 | 3843 | 7353 | 7776 | −200 | 134 | 189 | O |
| ATOM | 6390 | CB | HIS | B | 469 | −14.489 | 45.589 | 35.281 | 1.00 | 36.73 | | C |
| ANISOU | 6390 | CB | HIS | B | 469 | 2033 | 5718 | 6207 | 96 | 458 | 84 | C |
| ATOM | 6391 | CG | HIS | B | 469 | −14.207 | 46.700 | 36.246 | 1.00 | 39.32 | | C |
| ANISOU | 6391 | CG | HIS | B | 469 | 2509 | 6072 | 6358 | 233 | 648 | 26 | C |
| ATOM | 6392 | ND1 | HIS | B | 469 | −15.168 | 47.218 | 37.091 | 1.00 | 38.27 | | N |
| ANISOU | 6392 | ND1 | HIS | B | 469 | 2237 | 5938 | 6366 | 332 | 922 | 16 | N |
| ATOM | 6393 | CD2 | HIS | B | 469 | −13.070 | 47.389 | 36.505 | 1.00 | 37.44 | | C |
| ANISOU | 6393 | CD2 | HIS | B | 469 | 2551 | 5846 | 5828 | 288 | 601 | −29 | C |
| ATOM | 6394 | CE1 | HIS | B | 469 | −14.633 | 48.172 | 37.831 | 1.00 | 37.23 | | C |
| ANISOU | 6394 | CE1 | HIS | B | 469 | 2327 | 5816 | 6001 | 449 | 1027 | −49 | C |
| ATOM | 6395 | NE2 | HIS | B | 469 | −13.363 | 48.300 | 37.494 | 1.00 | 34.80 | | N |
| ANISOU | 6395 | NE2 | HIS | B | 469 | 2267 | 5514 | 5441 | 418 | 819 | −78 | N |
| ATOM | 6396 | N | PRO | B | 470 | −15.477 | 42.351 | 34.733 | 1.00 | 49.42 | | N |
| ANISOU | 6396 | N | PRO | B | 470 | 3378 | 7253 | 8144 | −250 | 400 | 248 | N |
| ATOM | 6397 | CA | PRO | B | 470 | −16.584 | 42.431 | 35.686 | 1.00 | 56.60 | | C |
| ANISOU | 6397 | CA | PRO | B | 470 | 4134 | 8158 | 9212 | −220 | 697 | 269 | C |
| ATOM | 6398 | C | PRO | B | 470 | −16.289 | 41.690 | 36.986 | 1.00 | 63.90 | | C |
| ANISOU | 6398 | C | PRO | B | 470 | 5152 | 9112 | 10017 | −271 | 1044 | 352 | C |
| ATOM | 6399 | O | PRO | B | 470 | −16.812 | 42.134 | 38.009 | 1.00 | 75.49 | | O |
| ANISOU | 6399 | O | PRO | B | 470 | 6601 | 10589 | 11492 | −191 | 1356 | 360 | O |
| ATOM | 6400 | CB | PRO | B | 470 | −17.740 | 41.770 | 34.929 | 1.00 | 52.03 | | C |
| ANISOU | 6400 | CB | PRO | B | 470 | 3377 | 7495 | 8897 | −301 | 535 | 274 | C |
| ATOM | 6401 | CG | PRO | B | 470 | −17.277 | 41.687 | 33.498 | 1.00 | 45.25 | | C |
| ANISOU | 6401 | CG | PRO | B | 470 | 2610 | 6597 | 7984 | −327 | 137 | 231 | C |
| ATOM | 6402 | CD | PRO | B | 470 | −15.824 | 41.489 | 33.594 | 1.00 | 41.03 | | C |
| ANISOU | 6402 | CD | PRO | B | 470 | 2295 | 6116 | 7180 | −352 | 122 | 245 | C |
| TER | | | | | | | | | | | | |
| HETATM | 6403 | N01 | LIG | C | 1 | −0.896 | 102.990 | 40.863 | 1.00 | 41.39 | | N |
| HETATM | 6404 | C02 | LIG | C | 1 | −1.594 | 104.168 | 40.969 | 1.00 | 45.62 | | C |
| HETATM | 6405 | O03 | LIG | C | 1 | −0.918 | 105.333 | 41.034 | 1.00 | 54.57 | | O |
| HETATM | 6406 | C04 | LIG | C | 1 | −1.556 | 106.350 | 40.250 | 1.00 | 59.42 | | C |
| HETATM | 6407 | C05 | LIG | C | 1 | −0.700 | 106.694 | 39.048 | 1.00 | 55.51 | | C |
| HETATM | 6408 | C06 | LIG | C | 1 | −1.108 | 106.307 | 37.757 | 1.00 | 57.74 | | C |
| HETATM | 6409 | C07 | LIG | C | 1 | −0.316 | 106.628 | 36.644 | 1.00 | 55.69 | | C |
| HETATM | 6410 | C08 | LIG | C | 1 | 0.885 | 107.333 | 36.824 | 1.00 | 52.66 | | C |
| HETATM | 6411 | C09 | LIG | C | 1 | 1.296 | 107.718 | 38.111 | 1.00 | 52.52 | | C |
| HETATM | 6412 | C10 | LIG | C | 1 | 0.502 | 107.397 | 39.223 | 1.00 | 51.12 | | C |
| HETATM | 6413 | O11 | LIG | C | 1 | −2.824 | 104.147 | 40.998 | 1.00 | 48.30 | | O |
| HETATM | 6414 | C12 | LIG | C | 1 | −1.635 | 101.724 | 40.813 | 1.00 | 24.79 | | C |
| HETATM | 6415 | C13 | LIG | C | 1 | −0.857 | 100.674 | 40.013 | 1.00 | 24.44 | | C |
| HETATM | 6416 | C14 | LIG | C | 1 | −0.390 | 101.204 | 38.659 | 1.00 | 24.41 | | C |
| HETATM | 6417 | O15 | LIG | C | 1 | −1.547 | 101.532 | 37.905 | 1.00 | 32.85 | | O |
| HETATM | 6418 | N16 | LIG | C | 1 | −2.475 | 100.488 | 37.870 | 1.00 | 27.83 | | N |
| HETATM | 6419 | C17 | LIG | C | 1 | −2.666 | 99.871 | 36.686 | 1.00 | 21.64 | | C |
| HETATM | 6420 | N18 | LIG | C | 1 | −1.966 | 100.250 | 35.604 | 1.00 | 20.11 | | N |
| HETATM | 6421 | N19 | LIG | C | 1 | −3.559 | 98.876 | 36.576 | 1.00 | 28.20 | | N |
| HETATM | 6422 | C20 | LIG | C | 1 | −1.747 | 101.084 | 42.223 | 1.00 | 26.01 | | C |
| HETATM | 6423 | O21 | LIG | C | 1 | −0.972 | 101.329 | 43.148 | 1.00 | 24.15 | | O |
| HETATM | 6424 | N22 | LIG | C | 1 | −2.764 | 100.187 | 42.437 | 1.00 | 23.71 | | N |
| HETATM | 6425 | C23 | LIG | C | 1 | −2.928 | 99.485 | 43.704 | 1.00 | 17.76 | | C |
| HETATM | 6426 | C24 | LIG | C | 1 | −3.945 | 100.149 | 44.634 | 1.00 | 23.15 | | C |
| HETATM | 6427 | C25 | LIG | C | 1 | −3.652 | 101.662 | 44.774 | 1.00 | 24.69 | | C |
| HETATM | 6428 | C26 | LIG | C | 1 | −3.750 | 99.434 | 45.992 | 1.00 | 20.53 | | C |
| HETATM | 6429 | C27 | LIG | C | 1 | −3.431 | 98.088 | 43.235 | 1.00 | 29.64 | | C |
| HETATM | 6430 | O28 | LIG | C | 1 | −4.625 | 97.880 | 42.990 | 1.00 | 25.83 | | O |
| HETATM | 6431 | N29 | LIG | C | 1 | −2.512 | 97.082 | 43.055 | 1.00 | 26.33 | | N |
| HETATM | 6432 | C30 | LIG | C | 1 | −2.940 | 95.766 | 42.564 | 1.00 | 23.66 | | C |
| HETATM | 6433 | C31 | LIG | C | 1 | −2.222 | 95.495 | 41.221 | 1.00 | 16.97 | | C |
| HETATM | 6434 | C32 | LIG | C | 1 | −2.461 | 96.604 | 40.177 | 1.00 | 28.78 | | C |
| HETATM | 6435 | C33 | LIG | C | 1 | −1.546 | 96.372 | 38.960 | 1.00 | 27.66 | | C |
| HETATM | 6436 | C34 | LIG | C | 1 | −3.929 | 96.623 | 39.706 | 1.00 | 28.33 | | C |
| HETATM | 6437 | C35 | LIG | C | 1 | −2.529 | 94.674 | 43.563 | 1.00 | 24.78 | | C |
| HETATM | 6438 | O36 | LIG | C | 1 | −1.160 | 94.882 | 43.910 | 1.00 | 26.58 | | O |
| HETATM | 6439 | C37 | LIG | C | 1 | −3.425 | 94.712 | 44.814 | 1.00 | 22.58 | | C |
| HETATM | 6440 | C38 | LIG | C | 1 | −4.793 | 94.041 | 44.508 | 1.00 | 27.80 | | C |
| HETATM | 6441 | O39 | LIG | C | 1 | −5.797 | 94.728 | 44.307 | 1.00 | 25.26 | | O |
| HETATM | 6442 | N40 | LIG | C | 1 | −4.874 | 92.661 | 44.475 | 1.00 | 29.54 | | N |
| HETATM | 6443 | C41 | LIG | C | 1 | −6.143 | 91.971 | 44.211 | 1.00 | 33.65 | | C |
| HETATM | 6444 | C42 | LIG | C | 1 | −6.287 | 90.841 | 45.246 | 1.00 | 36.28 | | C |
| HETATM | 6445 | C43 | LIG | C | 1 | −6.232 | 91.542 | 46.601 | 1.00 | 47.85 | | C |
| HETATM | 6446 | C44 | LIG | C | 1 | −7.376 | 92.186 | 47.082 | 1.00 | 53.77 | | C |
| HETATM | 6447 | C45 | LIG | C | 1 | −7.323 | 92.851 | 48.315 | 1.00 | 57.35 | | C |
| HETATM | 6448 | C46 | LIG | C | 1 | −6.128 | 92.873 | 49.052 | 1.00 | 54.79 | | C |
| HETATM | 6449 | C47 | LIG | C | 1 | −4.982 | 92.234 | 48.562 | 1.00 | 54.81 | | C |
| HETATM | 6450 | C48 | LIG | C | 1 | −5.037 | 91.568 | 47.332 | 1.00 | 56.44 | | C |
| HETATM | 6451 | N01 | LIG | C | 2 | −1.569 | 40.811 | 20.973 | 1.00 | 38.28 | | N |
| HETATM | 6452 | C02 | LIG | C | 2 | −1.041 | 39.649 | 20.461 | 1.00 | 44.96 | | C |
| HETATM | 6453 | O03 | LIG | C | 2 | −1.278 | 38.473 | 21.075 | 1.00 | 50.18 | | O |
| HETATM | 6454 | C04 | LIG | C | 2 | −1.991 | 37.609 | 20.171 | 1.00 | 52.70 | | C |
| HETATM | 6455 | C05 | LIG | C | 2 | −3.311 | 37.111 | 20.735 | 1.00 | 47.57 | | C |
| HETATM | 6456 | C06 | LIG | C | 2 | −3.379 | 36.525 | 22.004 | 1.00 | 43.50 | | C |
| HETATM | 6457 | C07 | LIG | C | 2 | −4.617 | 36.070 | 22.494 | 1.00 | 51.59 | | C |
| HETATM | 6458 | C08 | LIG | C | 2 | −5.788 | 36.191 | 21.729 | 1.00 | 49.19 | | C |
| HETATM | 6459 | C09 | LIG | C | 2 | −5.721 | 36.778 | 20.460 | 1.00 | 53.71 | | C |
| HETATM | 6460 | C10 | LIG | C | 2 | −4.484 | 37.234 | 19.969 | 1.00 | 56.58 | | C |
| HETATM | 6461 | O11 | LIG | C | 2 | −0.360 | 39.694 | 19.441 | 1.00 | 47.57 | | O |
| HETATM | 6462 | C12 | LIG | C | 2 | −1.323 | 42.082 | 20.293 | 1.00 | 25.01 | | C |
| HETATM | 6463 | C13 | LIG | C | 2 | −2.282 | 43.149 | 20.855 | 1.00 | 25.10 | | C |
| HETATM | 6464 | C14 | LIG | C | 2 | −3.757 | 42.739 | 20.709 | 1.00 | 32.03 | | C |
| HETATM | 6465 | O15 | LIG | C | 2 | −3.959 | 42.132 | 19.431 | 1.00 | 34.95 | | O |
| HETATM | 6466 | N16 | LIG | C | 2 | −3.762 | 43.058 | 18.406 | 1.00 | 33.64 | | N |
| HETATM | 6467 | C17 | LIG | C | 2 | −4.800 | 43.761 | 17.922 | 1.00 | 25.82 | | C |
| HETATM | 6468 | N18 | LIG | C | 2 | −6.044 | 43.584 | 18.420 | 1.00 | 23.83 | | N |
| HETATM | 6469 | N19 | LIG | C | 2 | −4.571 | 44.633 | 16.925 | 1.00 | 26.40 | | N |
| HETATM | 6470 | C20 | LIG | C | 2 | 0.055 | 42.692 | 20.620 | 1.00 | 29.44 | | C |
| HETATM | 6471 | O21 | LIG | C | 2 | 0.668 | 42.430 | 21.651 | 1.00 | 28.83 | | O |
| HETATM | 6472 | N22 | LIG | C | 2 | 0.580 | 43.586 | 19.723 | 1.00 | 24.89 | | N |
| HETATM | 6473 | C23 | LIG | C | 2 | 1.840 | 44.277 | 19.993 | 1.00 | 26.20 | | C |
| HETATM | 6474 | C24 | LIG | C | 2 | 3.111 | 43.573 | 19.487 | 1.00 | 26.99 | | C |
| HETATM | 6475 | C25 | LIG | C | 2 | 3.175 | 42.104 | 19.982 | 1.00 | 19.26 | | C |
| HETATM | 6476 | C26 | LIG | C | 2 | 4.254 | 44.347 | 20.179 | 1.00 | 16.14 | | C |
| HETATM | 6477 | C27 | LIG | C | 2 | 1.618 | 45.670 | 19.338 | 1.00 | 28.37 | | C |
| HETATM | 6478 | O28 | LIG | C | 2 | 1.901 | 45.891 | 18.158 | 1.00 | 31.13 | | O |
| HETATM | 6479 | N29 | LIG | C | 2 | 1.031 | 46.640 | 20.112 | 1.00 | 25.51 | | N |
| HETATM | 6480 | C30 | LIG | C | 2 | 0.729 | 47.992 | 19.604 | 1.00 | 26.52 | | C |
| HETATM | 6481 | C31 | LIG | C | 2 | −0.738 | 48.308 | 19.949 | 1.00 | 18.84 | | C |
| HETATM | 6482 | C32 | LIG | C | 2 | −1.689 | 47.196 | 19.475 | 1.00 | 28.26 | | C |
| HETATM | 6483 | C33 | LIG | C | 2 | −3.112 | 47.541 | 19.940 | 1.00 | 21.87 | | C |
| HETATM | 6484 | C34 | LIG | C | 2 | −1.663 | 47.070 | 17.935 | 1.00 | 29.92 | | C |
| HETATM | 6485 | C35 | LIG | C | 2 | 1.574 | 49.055 | 20.329 | 1.00 | 28.36 | | C |
| HETATM | 6486 | O36 | LIG | C | 2 | 1.480 | 48.768 | 21.734 | 1.00 | 28.10 | | O |
| HETATM | 6487 | C37 | LIG | C | 2 | 3.042 | 49.066 | 19.837 | 1.00 | 28.65 | | C |
| HETATM | 6488 | C38 | LIG | C | 2 | 3.208 | 49.851 | 18.498 | 1.00 | 31.15 | | C |
| HETATM | 6489 | O39 | LIG | C | 2 | 3.232 | 49.236 | 17.432 | 1.00 | 29.83 | | O |
| HETATM | 6490 | N40 | LIG | C | 2 | 3.358 | 51.230 | 18.502 | 1.00 | 31.27 | | N |
| HETATM | 6491 | C41 | LIG | C | 2 | 3.516 | 51.985 | 17.251 | 1.00 | 35.67 | | C |
| HETATM | 6492 | C42 | LIG | C | 2 | 4.962 | 51.917 | 16.713 | 1.00 | 46.44 | | C |
| HETATM | 6493 | C43 | LIG | C | 2 | 5.997 | 52.159 | 17.822 | 1.00 | 50.39 | | C |
| HETATM | 6494 | C44 | LIG | C | 2 | 6.706 | 51.079 | 18.355 | 1.00 | 49.31 | | C |
| HETATM | 6495 | C45 | LIG | C | 2 | 7.649 | 51.295 | 19.365 | 1.00 | 53.41 | | C |
| HETATM | 6496 | C46 | LIG | C | 2 | 7.894 | 52.593 | 19.845 | 1.00 | 63.13 | | C |
| HETATM | 6497 | C47 | LIG | C | 2 | 7.189 | 53.681 | 19.307 | 1.00 | 65.76 | | C |
| HETATM | 6498 | C48 | LIG | C | 2 | 6.240 | 53.456 | 18.293 | 1.00 | 62.46 | | C |
| END | | | | | | | | | | | | |

Note:
The coordinates in this Appendix describe the asymmetric unit of the crystal unit cell.

1. (canceled)

2. (canceled)

3. A method of identifying, designing and/or screening for a compound that can potentially interact with plasmepsin V and/or mimic WEHI-842 interacting with plasmepsin V, including performing structure-based identification, design and/or screening of a compound based on (i) the compound's interaction with a plasmepsin V structure and/or (ii) the compound's similarity with a WEHI-842 structure in complex with a plasmepsin V structure defined by the atomic coordinates of Appendix I or a subset thereof.

4. A method of identifying an inhibitor compound comprising an entity selected from the group consisting of an antibody, an antigen-binding fragment, a peptide, a non-peptide molecule and a chemical compound, wherein said inhibitor compound is capable of blocking biological activity resulting from an interaction with plasmepsin V, wherein said method includes:
introducing into a suitable computer program parameters defining an interacting surface based on the conformation of plasmepsin V in complex with WEHI-842 corresponding to the atomic coordinates of Appendix I or a subset thereof, wherein said program displays a three-dimensional model of the interacting surface;
creating a three-dimensional structure of a test compound in said computer program;
displaying a superimposing model of said test compound on the three-dimensional model of the interacting surface;
assessing whether said superimposing model of said test compound fits spatially and optionally energetically into a binding site;
synthesising said test compound;
incorporating said test compound in a biological activity assay; and
determining whether said test compound inhibits the biological activity of plasmepsin V

5. (canceled)

6. (canceled)

7. (canceled)

8. (canceled)

9. (canceled)

10. Use of the atomic coordinates or a subset thereof as shown in Appendix I at least representing:
(i) the enzyme domain of plasmepsin V;
(ii) the N-terminal subdomain of plasmepsin V;
(iii) the C-terminal subdomain of plasmepsin V;
(iv) the substrate-binding site of plasmepsin V;
(v) the flap from the N-terminal subdomain from plasmepsin V;
(vi) one or more regions of the flap in complex with WEHI-842; and/or
(vii) one or more regions of the substrate-binding site in complex with WEHI-842,
in identifying, designing and/or screening for a compound that can potentially interact with plasmepsin V or mimic WEHI-842 interacting with plasmepsin V, including performing structure-based identification, design and/or screening of a compound based on the compound's interactions with a plasmepsin V structure as defined by the atomic coordinates or a subset thereof or the compound's similarity with WEHI-842 in complex with plasmepsin V as defined by the atomic coordinates or a subset thereof.

11. (canceled)

12. (canceled)

13. (canceled)

14. A method of re-designing a compound which is known to bind to plasmepsin V comprising performing structure-based evaluation of the compound based on the compound's interactions with a plasmepsin V structure defined by the atomic coordinates of Appendix I or a subset thereof and/or the compound's similarity with a structure of WEHI-842 in complex with plasmepsin V as defined by the atomic coordinates of Appendix I or a subset thereof; and re-designing or chemically modifying the compound as a result of the evaluation.

15. (canceled)

16. (canceled)

17. (canceled)

18. (canceled)

19. A computer-assisted method of identifying a molecule able to interact with plasmepsin V using a programmed computer comprising a processor, which method comprises the steps of:
(a) generating, using computer methods, a set of atomic coordinates of a structure that possesses energetically favourable interactions with the atomic coordinates of:
(i) the substrate-binding site of plasmepsin V, the structure being defined by a subset of the atomic coordinates shown in Appendix I; and/or
(ii) at least portions of plasmepsin V, preferably including the flap, the structure being defined by a subset of the atomic coordinates shown in Appendix I, which coordinates are entered into the computer thereby generating a criteria data set;
(b) comparing, using the processor, the criteria data set to a computer database of chemical structures;
(c) selecting from the database, using computer methods, chemical structures which are complementary or similar to a region of the criteria data set; and
(d) optionally, outputting, to an output device, the selected chemical structures which are complementary to or similar to a region of the criteria data set.

20. A computer-assisted method of identifying potential mimetics of WEHI-842 using a programmed computer comprising a processor, the method comprising the steps of:
(a) generating a criteria data set from a set of atomic coordinates of:
(i) the substrate-binding site of plasmepsin V, the structure being defined by a subset of the atomic coordinates shown in Appendix I;
(ii) at least a portion of plasmepsin V, preferably including the flap, the structure being defined by a subset of the atomic coordinates shown in Appendix I; and/or WEHI-842, the structure being defined by a subset of the atomic coordinates shown in Appendix I, which coordinates are entered into the computer;
(b): (i) comparing, using the processor, the criteria data set to a computer database of chemical structures stored in a computer data storage system and selecting from the database, using computer methods, chemical structures having a region that is structurally similar to the criteria data set; or
(ii) constructing, using computer methods, a model of a chemical structure having a region that is structurally similar to the criteria data set; and
(c) optionally, outputting to an output device:
(i) the selected chemical structures from step (b)(i) having a region similar to the criteria data set; or
(ii) the constructed model from step (b)(ii).

21. (canceled)

22. (canceled)

23. (canceled)

24. (canceled)

25. (canceled)

26. (canceled)

27. (canceled)

28. (canceled)

29. (canceled)
